(19) United States
(12) Patent Application Publication
(10) Pub. No.: US 2021/0214615 A1
(43) Pub. Date: Jul. 15, 2021

(54) LIQUID CRYSTAL DISPLAY DEVICE AND DISPLAY UNIT

(71) Applicants: JNC CORPORATION, Tokyo (JP); JNC PETROCHEMICAL CORPORATION, Tokyo (JP)

(72) Inventors: Yuko KATANO, Chiba (JP); Fumitaka KONDO, Chiba (JP); Kazuhiro OGITA, Chiba (JP); Hiroshi ENDOU, Chiba (JP)

(73) Assignees: JNC CORPORATION, Tokyo (JP); JNC PETROCHEMICAL CORPORATION, Tokyo (JP)

(21) Appl. No.: 16/322,493

(22) PCT Filed: Aug. 3, 2017
(86) PCT No.: PCT/JP2017/028326

§ 371 Date: Feb. 1, 2019

(30) Foreign Application Priority Data
Aug. 3, 2016 (JP) 2016-153266

(51) Int. Cl. C09K 19/56; C09K 19/30; G02F 1/1343; G02F 1/1337

(52) U.S. Cl. CPC C09K 19/56; C09K 19/3001; C09K 19/3003; C09K 19/3066; G02F 1/134309; C09K 2019/3016; G02F 1/133742; C09K 2019/3004; C09K 2019/3009; C09K 2019/301; G02F 1/133711

(57) ABSTRACT

The liquid crystal display device of the disclosure has: a first substrate; a plurality of pixel electrodes formed on the first substrate; a second substrate; a counter electrode formed on the second substrate and facing the pixel electrode; a liquid crystal layer including a liquid crystal composition between the pixel electrode and the counter electrode; and an alignment control layer formed of a polymer containing an alignable monomer that is one component of the liquid crystal composition, in which the alignment control layers are each formed on a side of the first substrate and on a side of the second substrate. The alignable monomer is a polymerizable polar compound having a mesogen moiety formed of at least one ring, and a polar group.

### TECHNICAL FIELD

The invention relates to a liquid crystal display device. More specifically, the invention relates to a liquid crystal display device including a liquid crystal composition containing a polymerizable polar compound and having a positive or negative dielectric anisotropy.

### BACKGROUND ART

In a liquid crystal display device, a classification based on an operating mode of liquid crystal molecules includes a mode such as a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode and a field-induced photo-reactive alignment (FPA) mode. A classification based on a driving mode in the device includes a passive matrix (PM) and an active matrix (AM). The PM is classified into static, multiplex and so forth, and the AM is classified into a thin film transistor (TFT), a metal insulator metal (MIM) and so forth. The TFT is classified into amorphous silicon and polycrystal silicon. The latter is classified into a high temperature type and a low temperature type according to a production process. A classification based on a light source includes a reflective type utilizing natural light, a transmissive type utilizing backlight, and a transflective type utilizing both the natural light and the backlight.

The liquid crystal display device includes a liquid crystal composition having a nematic phase. The composition has suitable characteristics. An AM device having good characteristics can be obtained by improving characteristics of the composition. A relationship between two characteristics is summarized in Table 1. The characteristics of the composition will be further described based on a commercially available AM device. A temperature range of the nematic phase relates to a temperature range in which the device can be used. A preferred maximum temperature of the nematic phase is about 70° C. or higher and a preferred minimum temperature of the nematic phase is about −10° C. or lower. Viscosity of the composition relates to a response time in the device. A short response time is preferred for displaying moving images on the device. A shorter response time even by one millisecond is desirable. Accordingly, a small viscosity in the composition is preferred. A small viscosity at low temperature is further preferred.

TABLE 1
Table 1. Characteristics of composition and AM device

| | Characteristics of | Characteristics of |
|---|---|---|
| No. | composition | AM device |
| 1 | Wide temperature range of a | Wide usable temperature |
| | nematic phase | range |
| 2 | Small viscosity ¹⁾ | Short response time |
| 3 | Suitable optical anisotropy | Large contrast ratio |
| 4 | Large positive or negative | Low threshold voltage |
| | dielectric anisotropy | and small electric power |
| | | consumption |
| | | Large contrast ratio |
| 5 | Large specific resistance | Large voltage holding ratio |
| | | and large contrast ratio |
| 6 | High stability to ultraviolet | Long service life |
| | light and heat | |
| 7 | Large elastic constant | Large contrast ratio and |
| | | short response time |

¹⁾ A composition can be injected into a liquid crystal display device in a short time.

Optical anisotropy of the composition relates to a contrast ratio in the device. According to a mode of the device, large optical anisotropy or small optical anisotropy, more specifically, suitable optical anisotropy is required. A product (Δn×d) of the optical anisotropy (Δn) of the composition and a cell gap (d) in the device is designed so as to maximize the contrast ratio. A suitable value of the product depends on a type of the operating mode. In a device having a mode such as TN, the value is about 0.45 micrometer. In a device having the VA mode, the value is in the rage of about 0.30 micrometer to about 0.40 micrometer, and in a device having the IPS mode or the FFS mode, the value is in the rage of about 0.20 micrometer to about 0.30 micrometer. In the above case, a composition having the large optical anisotropy is preferred for a device having a small cell gap. Large dielectric anisotropy in the composition contributes to a low threshold voltage, small electric power consumption and a large contrast ratio in the device. Accordingly, large positive or negative dielectric anisotropy is preferred. Large specific resistance in the composition contributes to a large voltage holding ratio and a large contrast ratio in the device. Accordingly, a composition having the large specific resistance at room temperature and also at a temperature close to a maximum temperature of the nematic phase in an initial stage is preferred. The composition having the large specific resistance at room temperature and also at the temperature close to the maximum temperature of the nematic phase even after the device has been used for a long period of time is preferred. Stability of the composition to ultraviolet light and heat relates to a service life of the device. In the case where the stability is high, the device has a long service life. Such characteristics are preferred for an AM device used in a liquid crystal projector, a liquid crystal television and so forth.

In a liquid crystal display device having a polymer sustained alignment (PSA) mode, a liquid crystal composition containing a polymer is used. First, a composition to which a small amount of a polymerizable compound is added is injected into the device. Next, the composition is irradiated with ultraviolet light while voltage is applied between substrates of the device. The polymerizable compound is polymerized to form a network structure of the polymer in the composition. In the composition, alignment of the liquid crystal molecules can be controlled by the polymer, and therefore the response time in the device is shortened and also image persistence is improved. Such an effect of the polymer can be expected for a device having the mode such as the TN mode, the ECB mode, the OCB mode, the IPS mode, the VA mode, the FFS mode and the FPA mode.

In a general-purpose liquid crystal display device, vertical alignment of the liquid crystal molecules is achieved by a polyimide alignment film. On the other hand, in a liquid crystal display device having no alignment film, a liquid crystal composition containing a polar compound and a polymer is used. First, a composition to which a small amount of the polar compound and a small amount of the polymerizable compound are added is injected into the device. Here, the liquid crystal molecules are aligned by action of the polar compounds. Next, the composition is irradiated with ultraviolet light while voltage is applied between substrates of the device. Here, the polymerizable compound is polymerized to stabilize the alignment of the liquid crystal molecules. In the composition, the alignment of the liquid crystal molecules can be controlled by the polar compound and the polymer, and therefore the response time of the device is shortened, and the image persistence is improved. Further, in the device having no alignment film, a step of forming an alignment film is unnecessary. The device has no alignment film, and therefore electric resistance of the device is not decreased by interaction between the alignment film and the composition. Such an effect due to a combination of the polar compound and the polymer can be expected in a device having the mode such as the TN mode, the ECB mode, the OCB mode, the IPS mode, the VA mode, the FFS mode and the FPA mode.

In the liquid crystal display device having no alignment film, various compounds each having a —OH group at a terminal have been so far prepared as a compound in which the liquid crystal molecules can be vertically aligned. Patent literature No. 1 describes biphenyl compound (S-1) having a —OH group at a terminal. However, in the compound, capability of vertically aligning the liquid crystal molecules is high, but a voltage holding ratio is not sufficiently large when the compound is used in the liquid crystal display device.

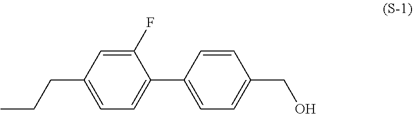 [SMILES: CCCc1ccc(-c2ccc(CO)cc2)c(F)c1]

### CITATION LIST

### Patent Literature

Patent literature No. 1: WO 2014/090362 A.

Patent literature No. 2: WO 2014/094959 A.

Patent literature No. 3: WO 2013/004372 A.

Patent literature No. 4: WO 2012/104008 A.

Patent literature No. 5: WO 2012/038026 A.

Patent literature No. 6: JP S50-35076 A.

### SUMMARY OF INVENTION

### Technical Problem

An object of the present invention is to provide a liquid crystal display device having characteristics such as a wide temperature range in which the device can be used, a short response time, a high voltage holding ratio, a low threshold voltage, a large contrast ratio and a long service life by containing a liquid crystal composition that has high chemical stability, high capability of aligning liquid crystal molecules and high solubility in the liquid crystal composition, contains a polar compound having a large voltage holding ratio when the liquid crystal composition is used in the liquid crystal display device and satisfies at least one of characteristics such as high maximum temperature of a nematic phase, low minimum temperature of the nematic phase, small viscosity, suitable optical anisotropy, large positive or negative dielectric anisotropy, large specific resistance, high stability to ultraviolet light, high stability to heat and a large elastic constant.

### Solution to Problem

In order to solve the problems, the present inventors have conducted study on various liquid crystal compositions, and as a result, have found that, if a polymerizable polar compound having a mesogen moiety formed of at least one ring, and a polar group is incorporated into a liquid crystal composition, the problem can be solved without providing a conventional alignment film such as a polyimide alignment film used in a general-purpose liquid crystal display device on a substrate in a method of introducing the liquid crystal composition into a device, and then polymerizing a polymerizable compound in the liquid crystal composition by irradiation of an activated energy ray while applying voltage between electrodes, and thus have completed the present invention.

A liquid crystal display device according to a first aspect of the invention has: a first substrate; a plurality of pixel electrodes formed on the first substrate; a second substrate; a counter electrode formed on the second substrate and facing the pixel electrode; a liquid crystal layer including a liquid crystal composition between the pixel electrode and the counter electrode; and alignment control layers each formed of a polymer containing an alignable monomer that is one component of the liquid crystal composition, and formed on a side of the first substrate and on a side of the second substrate, wherein the alignable monomer is a polymerizable polar compound having a mesogen moiety formed of at least one ring, and a polar group. If the device is configured in such a manner, liquid crystal compounds in the liquid crystal composition can be vertically aligned by the alignment control layer without forming an alignment film.

In a liquid crystal display device according to a second aspect of the invention, the mesogen moiety includes a cyclohexane ring in the liquid crystal display device according to the first aspect of the invention.

If the device is configured in such a manner, a voltage holding ratio (VHR) as electrical characteristics can be further improved.

In a liquid crystal display device according to a third aspect of the invention, the alignable monomer is a compound represented by formula (1α) in the liquid crystal display device according to the first or second aspect of the invention.

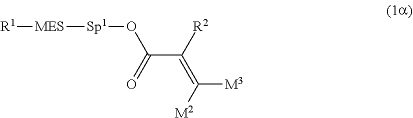

In a liquid crystal display device according to a fourth aspect of the invention, the alignable monomer is a compound represented by formula (1β) in the liquid crystal display device according to the first or second aspect of the invention.

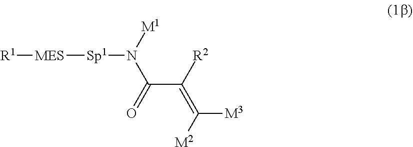

In a liquid crystal display device according to a fifth aspect of the invention, the alignable monomer is a compound represented by formula (1γ) in the liquid crystal display device according to the first or second aspect of the invention.

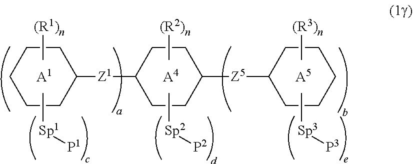

In a liquid crystal display device according to a sixth aspect of the invention, the alignable monomer is a compound represented by formula (1δ-1) in the liquid crystal display device according to the first or second aspect of the invention.

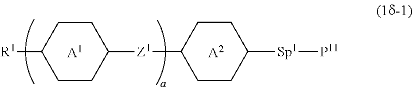

In a liquid crystal display device according to a seventh aspect of the invention, the alignable monomer is a compound represented by formula (1ε) in the liquid crystal display device according to the first or second aspect of the invention.

R¹-MES-Sp¹-P¹ (1ε)

In a liquid crystal display device according to an eighth aspect of the invention, the polymer containing the alignable monomer is a copolymer with a reactive monomer in the liquid crystal display device according to any one of the first to seventh aspects of the invention.

If the device is configured in such a manner, reactivity (polymerizability) can be improved by using the reactive monomer.

In a liquid crystal display device according to a ninth aspect of the invention, the alignment control layer has a thickness of 10 to 100 nanometers in the liquid crystal display device according to any one of the first to eighth aspects of the invention.

In a liquid crystal display device according to a tenth aspect of the invention, at least one liquid crystal compound contained in the liquid crystal composition has negative dielectric anisotropy in the liquid crystal display device according to any one of the first to ninth aspects of the invention.

In a liquid crystal display device according to an eleventh aspect of the invention, molecular alignment of the liquid crystal compound contained in the liquid crystal composition is vertical alignment relative to a surface of the substrate by the alignment control layer, and an angle of the vertical alignment to the substrate is 90±10 degrees in the liquid crystal display device according to any one of the first to tenth aspects of the invention.

In a liquid crystal display device according to a twelfth aspect of the invention, the molecular alignment of the liquid crystal compound contained in the liquid crystal composition is divided as aligned for every pixel in the liquid crystal display device according to any one of the first to eleventh aspects of the invention.

In a liquid crystal display device according to a thirteenth aspect of the invention, the liquid crystal display device according to any one of the first to twelfth aspects of the invention has no alignment film. A term “alignment film” means a film having an alignment control function of a polyimide alignment film that is formed on the substrate before injecting the liquid crystal compound into the device, or the like.

If the device is configured in such a manner, a step of forming the alignment film in a production step of the device becomes unnecessary.

A display unit according to a fourteenth aspect of the invention has: the liquid crystal display device according to any one of the first to thirteenth aspects of the invention; and a backlight.

If the device is configured in such a manner, the display unit suitable for the display unit such as a liquid crystal television can be formed.

### Advantageous Effects of Invention

An advantage of the invention is to provide a liquid crystal display device having characteristics such as a wide temperature range in which the device can be used, a short response time, a high voltage holding ratio, a low threshold voltage, a large contrast ratio and a long service life by containing a liquid crystal composition that has high chemical stability, high capability of aligning liquid crystal molecules and high solubility in the liquid crystal composition, contains a polymerizable polar compound having a large voltage holding ratio when the liquid crystal composition is used in the liquid crystal display device and satisfies at least one of characteristics such as high maximum temperature of a nematic phase, low minimum temperature of the nematic phase, small viscosity, suitable optical anisotropy, large positive or negative dielectric anisotropy, large specific resistance, high stability to ultraviolet light, high stability to heat and a large elastic constant.

### BRIEF DESCRIPTION OF DRAWINGS

FIG. 1 is a schematic view showing device 11 in a state in which polymerizable polar compound 5 as an alignable monomer is arranged on color filter substrate 1 and array substrate 2 by interaction of a polar group with a substrate surface (an electrode layer is not shown), in which an alignment control layer is formed by a polymerization reaction.

FIG. 2 is a schematic view showing device 12 in a state in which polymerizable polar compound 5 as an alignable monomer is arranged on color filter substrate 1 and array substrate 2 by interaction between a polar group and a substrate surface (an electrode layer is not shown), in which an alignment control layer is formed by incorporating polymerizable compound 6 as a reactive monomer by polymerization reaction.

FIG. 3 is a schematic view of conventional device 21 having an alignment film and containing a polymerizable compound (an electrode layer is not shown).

### DESCRIPTION OF EMBODIMENTS

The present application is based on Japanese Patent Application No. 2016-153266 filed on Aug. 3, 2016 in Japan, and is hereby incorporated by reference in its entirety in the present application. The invention can be further completely understood by the following detailed description. A further application scope of the invention will become apparent by the detailed description described below. However, the detailed description and a specific embodiment are desirable embodiments of the invention, and described only for illustrative purposes because various possible changes and modifications will be apparent to those having ordinary skill in the art on the basis of the detailed description within spirit and the scope of the invention. The applicant has no intention to dedicate to the public any described embodiment, and among the modifications and alternatives, those which may not literally fall within the scope of the present claims constitute a part of the invention in the sense of the doctrine of equivalents.

Usage of terms herein is as described below. Terms “liquid crystal composition” and “liquid crystal display device” may be occasionally abbreviated as “composition” and “device,” respectively. A term “liquid crystal display device” is a generic term for a liquid crystal display panel and a liquid crystal display module. A term “liquid crystal compound” is a generic term for a compound having a liquid crystal phase such as a nematic phase and a smectic phase, and a compound having no liquid crystal phase but to be mixed with the composition for the purpose of adjusting characteristics such as a temperature range of the nematic phase, viscosity and dielectric anisotropy. The compound has a six-membered ring such as 1,4-cyclohexylene and 1,4-phenylene, and has rod-like molecular structure. “Polymerizable compound” is a compound to be added for the purpose of forming a polymer in the composition. “Polar compound” aids a polar group to cause interaction a substrate surface, thereby causing arrangement of liquid crystal molecules.

The liquid crystal composition is prepared by mixing a plurality of liquid crystal compounds. A proportion (content) of the liquid crystal compounds is expressed in terms of weight percent (% by weight) based on the weight of the liquid crystal composition. An additive such as an optically active compound, an antioxidant, an ultraviolet light absorber, a dye, an antifoaming agent, the polymerizable compound, a polymerization initiator, a polymerization inhibitor and a polar compound is added to the liquid crystal composition when necessary. A proportion (amount of addition) of the additive is expressed in terms of weight percent (% by weight) based on the weight of the liquid crystal composition in a manner similar to the proportion of the liquid crystal compounds. Weight parts per million (ppm) may be occasionally used. A proportion of the polymerization initiator and the polymerization inhibitor is exceptionally expressed based on the weight of the polymerizable compound.

A compound represented by formula (1) may be occasionally abbreviated as “compound (1).” Compound (1) means one compound, a mixture of two compounds or a mixture of three or more compounds represented by formula (1). A same rule applies also to at least one compound selected from the group of compounds represented by formula (2), or the like. A symbol such as B¹, C¹ and F surrounded by a hexagonal shape corresponds to ring B¹, ring C¹ and ring F, respectively. The hexagonal shape represents a six-membered ring such as a cyclohexane ring and a benzene ring or a fused ring such as a naphthalene ring. An oblique line crossing one the hexagonal shape represents that arbitrary hydrogen on the ring may be replaced by a group such as -Sp¹-P¹. A subscript such as e represents the number of groups subjected to replacement. When the subscript is 0, such replacement is not performed.

A symbol of terminal group R¹¹ is used in a plurality of component compounds. In the compounds, two groups represented by two pieces of arbitrary R¹¹ may be identical or different. For example, in one case, R¹¹ of compound (2) is ethyl and R¹¹ of compound (3) is ethyl. In another case, R¹¹ of compound (2) is ethyl and R¹¹ of compound (3) is propyl. A same rule applies also to a symbol of any other terminal group, a ring, a bonding group or the like. In formula (8), when i is 2, two of ring D¹ exists. In the compound, two groups represented by two of ring D¹ may be identical or different. A same rule applies also to two of arbitrary ring D¹ when i is larger than 2. A same rule applies also to a symbol of any other ring, a bonding group or the like.

An expression “at least one ‘A’” means that the number of ‘A’ is arbitrary. An expression “at least one ‘A’ may be replaced by ‘B’” means that, when the number of ‘A’ is 1, a position of ‘A’ is arbitrary, and also when the number of ‘A’ is 2 or more, positions thereof can be selected without restriction. A same rule applies also to an expression “at least one ‘A’ is replaced by ‘B’.” An expression “at least one A may be replaced by B, C or D” means including a case where at least one A is replaced by B, a case where at least one A is replaced by C, and a case where at least one A is replaced by D, and also a case where a plurality of pieces of A are replaced by at least two pieces of B, C and D. For example, alkyl in which at least one —CH₂— (or —(CH₂)₂—) may be replaced by —O— (or —CH═CH—) includes alkyl, alkenyl, alkoxy, alkoxyalkyl, alkoxyalkenyl and alkenyloxyalkyl. In addition, a case where two pieces of consecutive —CH₂— are replaced by —O— to form —O—O— is not preferred. In alkyl or the like, a case where —CH₂— of a methyl part (—CH₂—H) is replaced by —O— to form —O—H is not preferred, either.

Halogen means fluorine, chlorine, bromine or iodine. Preferred halogen is fluorine or chlorine. Further preferred halogen is fluorine. Alkyl is straight-chain alkyl or branched-chain alkyl, but includes no cyclic alkyl. In general, straight-chain alkyl is preferred to branched-chain alkyl. A same rule applies also to a terminal group such as alkoxy and alkenyl. With regard to a configuration of 1,4-cyclohexylene, trans is preferred to cis for increasing the maximum temperature of the nematic phase. Then, 2-fluoro-1,4-phenylene means two divalent groups described below. In a chemical formula, fluorine may be leftward (L) or rightward (R). A same rule applies also to an asymmetrical divalent group formed by removing two hydrogens from a ring, such as tetrahydropyran-2,5-diyl.

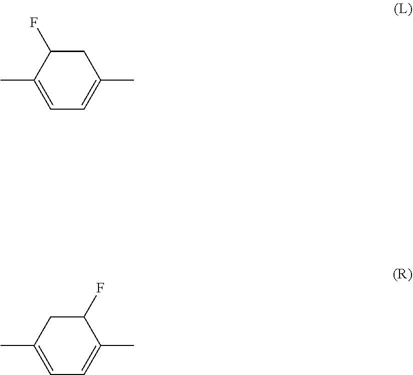

The liquid crystal display device of the invention includes, in the liquid crystal composition, a polymerizable polar compound that functions as an alignable monomer and has a mesogen moiety formed of at least one ring, and a polar group. At least one ring is preferably a cyclohexane ring. The polymerizable polar compound is referred to as compound (1) herein. Further, in a case of referring to structure in detail or the like, when necessary, the polymerizable polar compound is separately referred to as compound (1α), compound (1β), compound (1γ), compound (1δ) or compound (1ε).

Compound (1) will be described in sections 1. Example of compound (1α), 2. Form of compound (1α), 3. Synthesis of compound (1α), 4. Example of compound (1β), 5. Form of compound (1β), 6. Synthesis of compound (1β), 7. Example of compound (1γ), 8. Form of compound (1γ), 9. Synthesis of compound (1γ), 10. Example of compound (1δ), 11. Form of compound (1δ), 12. Synthesis of compound (1δ), 13. Example of compound (1ε), 14. Form of compound (1ε) and 15. Synthesis of compound (1ε);

a composition containing compound (1) will be described in section 16. Liquid crystal composition; and

a device including the composition will be described in section 17. Liquid crystal display device in the order thereof.

### 1. Example of Compound (1α)

Compound (1α) will be described as an example in the following items.

Item 1. A compound, represented by formula (1α):

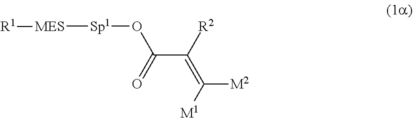

wherein, in formula (1α),

R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;

MES is a mesogen group having at least one ring;

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, halogen, alkyl having 1 to 5 carbons, or alkyl having 1 to 5 carbons in which at least one hydrogen is replaced by halogen; and

R² is a group represented by formula (1αa), (1αb) or (1αc):

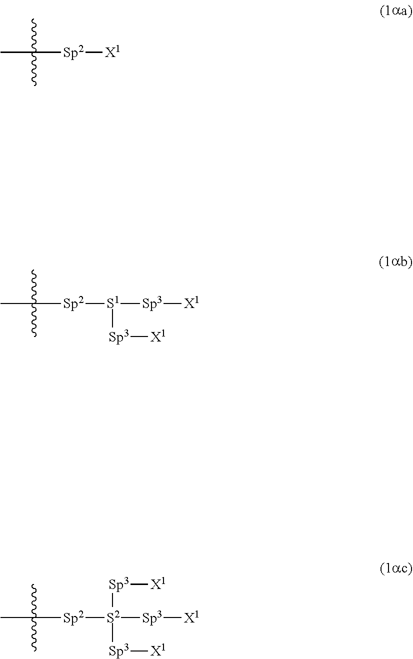

wherein, in formulas (1αa), (1αb) and (1αc),

Sp² and Sp³ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

S¹ is >CH— or >N—;

S² is >C< or >Si<; and

X¹ is a group represented by —OH, —NH₂, —OR³, —N(R³)₂, formula (x1), —COOH, —SH, —B(OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen, and w in formula (x1) is 1, 2, 3 or 4.

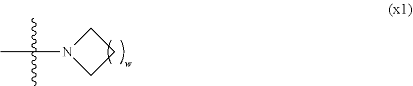

Item 2. The compound according to item 1, represented by formula (1α-1):

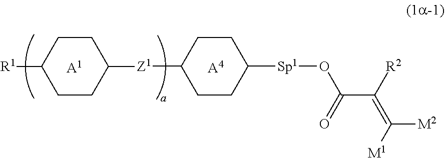

wherein, in formula (1α-1),

R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;

ring A¹ and ring A⁴ are independent 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;

Z¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, halogen, alkyl having 1 to 5 carbons, or alkyl having 1 to 5 carbons in which at least one hydrogen is replaced by halogen;

a is 0, 1, 2, 3 or 4; and

R² is a group represented by formula (1αa) or (1αb):

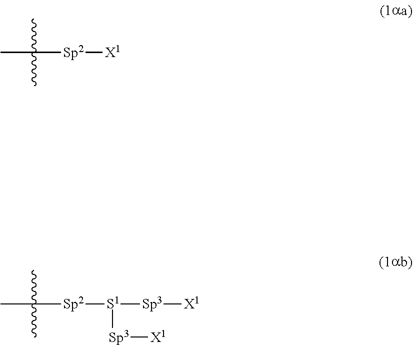

wherein, in formulas (1αa) and (1αb),

Sp² and Sp³ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

S¹ is >CH— or >N—; and

X¹ is a group represented by —OH, —NH₂, —OR³, —N(R³)₂, formula (x1), —COOH, —SH, —B(OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen, and w in formula (x1) is 1, 2, 3 or 4.

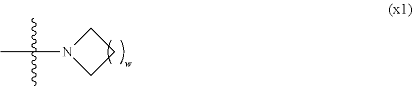

Item 3. The compound according to item 1 or 2, represented by formula (1α-2):

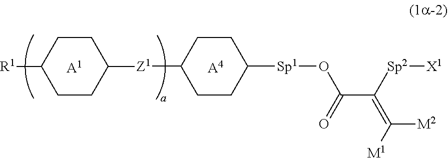

wherein, in formula (1α-2),

R¹ is alkyl having 1 to 15 carbons, alkenyl having 2 to 15 carbons, alkoxy having 1 to 14 carbons or alkenyloxy having 2 to 14 carbons, and in the groups, at least one hydrogen may be replaced by fluorine or chlorine;

ring A¹ and ring A⁴ are independently 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;

Z¹ is a single bond, —(CH₂)₂—, —CH═CH—, —C≡C—, —COO—, —OCO—, —CF₂O—, —OCF₂—, —CH₂O—, —OCH₂— or —CF═CF—;

Sp¹ and Sp² are independently a single bond or alkylene having 1 to 10 carbons, and in the alkylene, at least one —CH₂— may be replaced by —O—, —COO— or —OCO—, and at least one —(CH₂)₂— may be replaced by —CH═CH—, and in the groups, at least one hydrogen may be replaced by fluorine or chlorine;

M¹ and M² are independently hydrogen, fluorine, alkyl having 1 to 5 carbons, or alkyl having 1 to 5 carbons in which at least one hydrogen is replaced by fluorine; and

X¹ is a group represented by —OH, —NH₂, —OR³, —N(R³)₂, formula (x1), —COOH, —SH, —B(OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by fluorine or chlorine, and w in formula (x1) is 1, 2, 3 or 4:

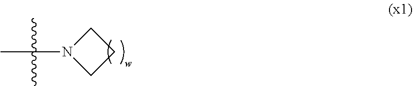

wherein a is 0, 1, 2, 3 or 4.

Item 4. The compound according to any one of items 1 to 3, represented by any one of formulas (1α-3) to (1α-6):

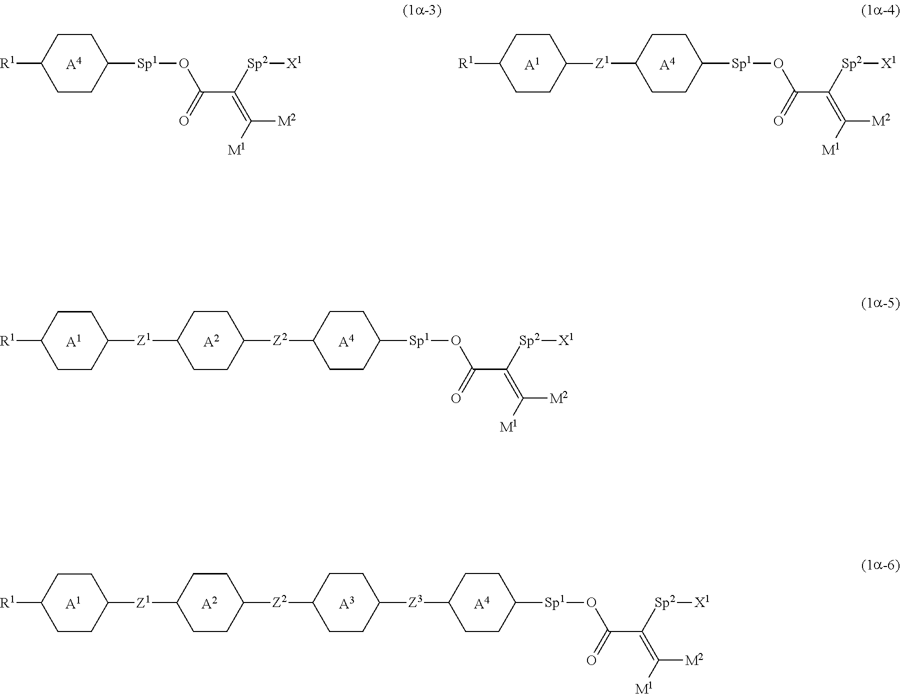

wherein, in formulas (1α-3) to (1α-6),

R¹ is alkyl having 1 to 15 carbons, alkenyl having 2 to 15 carbons, alkoxy having 1 to 14 carbons or alkenyloxy having 2 to 14 carbons, and in the groups, at least one hydrogen may be replaced by fluorine;

ring A¹, ring A², ring A³ and ring A⁴ are independently 1,4-cyclohexylene, 1,4-cyclohexenylene, 1,4-phenylene, naphthalene-2,6-diyl, decahydronaphthalene-2,6-diyl, tetrahydropyran-2,5-diyl, 1,3-dioxane-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 7 carbons, alkenyl having 2 to 7 carbons or alkoxy having 1 to 6 carbons;

Z¹, Z² and Z³ are independently a single bond, —(CH₂)₂—, —CH═CH—, —C≡C—, —COO—, —OCO—, —CF₂O—, —OCF₂—, —CH₂O—, —OCH₂— or —CF═CF—;

Sp¹ and Sp² are independently a single bond or alkylene having 1 to 7 carbons, and in the alkylene, at least one —CH₂— may be replaced by —O—, —COO— or —OCO—, and at least one —(CH₂)₂— may be replaced by —CH═CH—, and in the groups, at least one hydrogen may be replaced by fluorine;

M¹ and M² are independently hydrogen, fluorine, methyl, ethyl or trifluoromethyl; and

X¹ is a group represented by —OH, —NH₂, —OR³, —N(R³)₂, formula (x1) or —Si(R³)₃, in which R³ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine, and w in formula (x1) is 1, 2, 3 or 4.

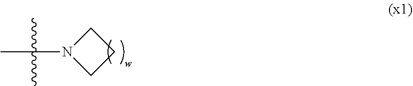

Item 5. The compound according to any one of items 1 to 4, represented by any one of formulas (1α-7) to (1α-10):

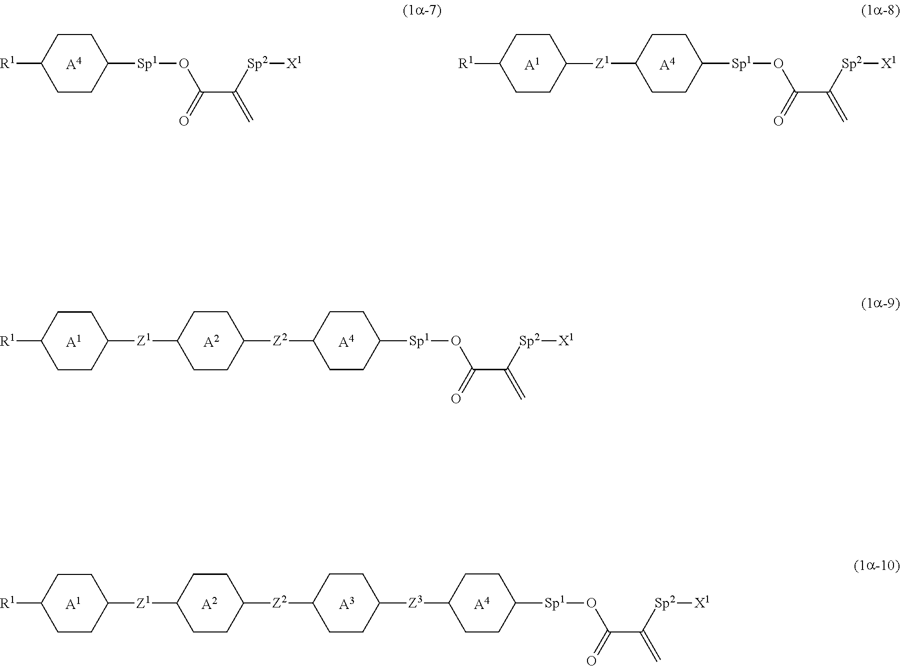

wherein, in formulas (1α-7) to (1α-10),

R¹ is alkyl having 1 to 10 carbons, alkenyl having 2 to 10 carbons or alkoxy having 1 to 9 carbons, and in the groups, at least one hydrogen may be replaced by fluorine;

ring A¹, ring A², ring A³ and ring A⁴ are independently 1,4-cyclohexylene, 1,4-cyclohexenylene, 1,4-phenylene, tetrahydropyran-2,5-diyl, 1,3-dioxane-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 5 carbons, alkenyl having 2 to 5 carbons or alkoxy having 1 to 4 carbons;

Z¹, Z² and Z³ are independently a single bond, —(CH₂)₂— or —CH═CH—;

Sp¹ is a single bond or alkylene having 1 to 7 carbons, and in the alkylene, at least one —CH₂— may be replaced by —O—, and at least one —(CH₂)₂— may be replaced by —CH═CH—;

Sp² is alkylene having 1 to 7 carbons, and in the alkylene, at least one —CH₂— may be replaced by —O—; and

X¹ is —OH, —NH₂ or —N(R³)₂, in which R³ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine.

Item 6. The compound according to any one of items 1 to 5, represented by any one of formulas (1α-11) to (1α-14):

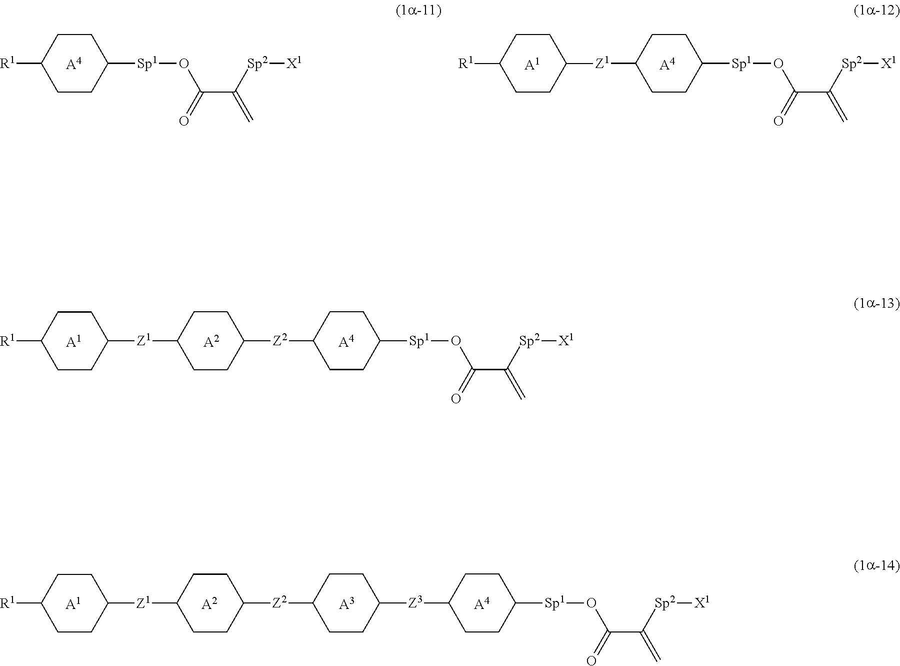

wherein, in formulas (1α-11) to (1α-14),

R¹ is alkyl having 1 to 10 carbons, alkenyl having 2 to 10 carbons or alkoxy having 1 to 9 carbons, and in the groups, at least one hydrogen may be replaced by fluorine;

ring A¹, ring A², ring A³ and ring A⁴ are independently 1,4-cyclohexylene, 1,4-phenylene, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons;

Z¹, Z² and Z³ are independently a single bond or —(CH₂)₂—;

Sp¹ is a single bond or alkylene having 1 to 5 carbons, and in the alkylene, at least one —CH₂— may be replaced by —O—;

Sp² is alkylene having 1 to 5 carbons, and in the alkylene, at least one —CH₂— may be replaced by —O—; and

X¹ is —OH, —NH₂ or —N(R³)₂, in which R³ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine.

Item 7. The compound according to any one of items 1 to 6, represented by any one of formulas (1α-15) to (1α-31):

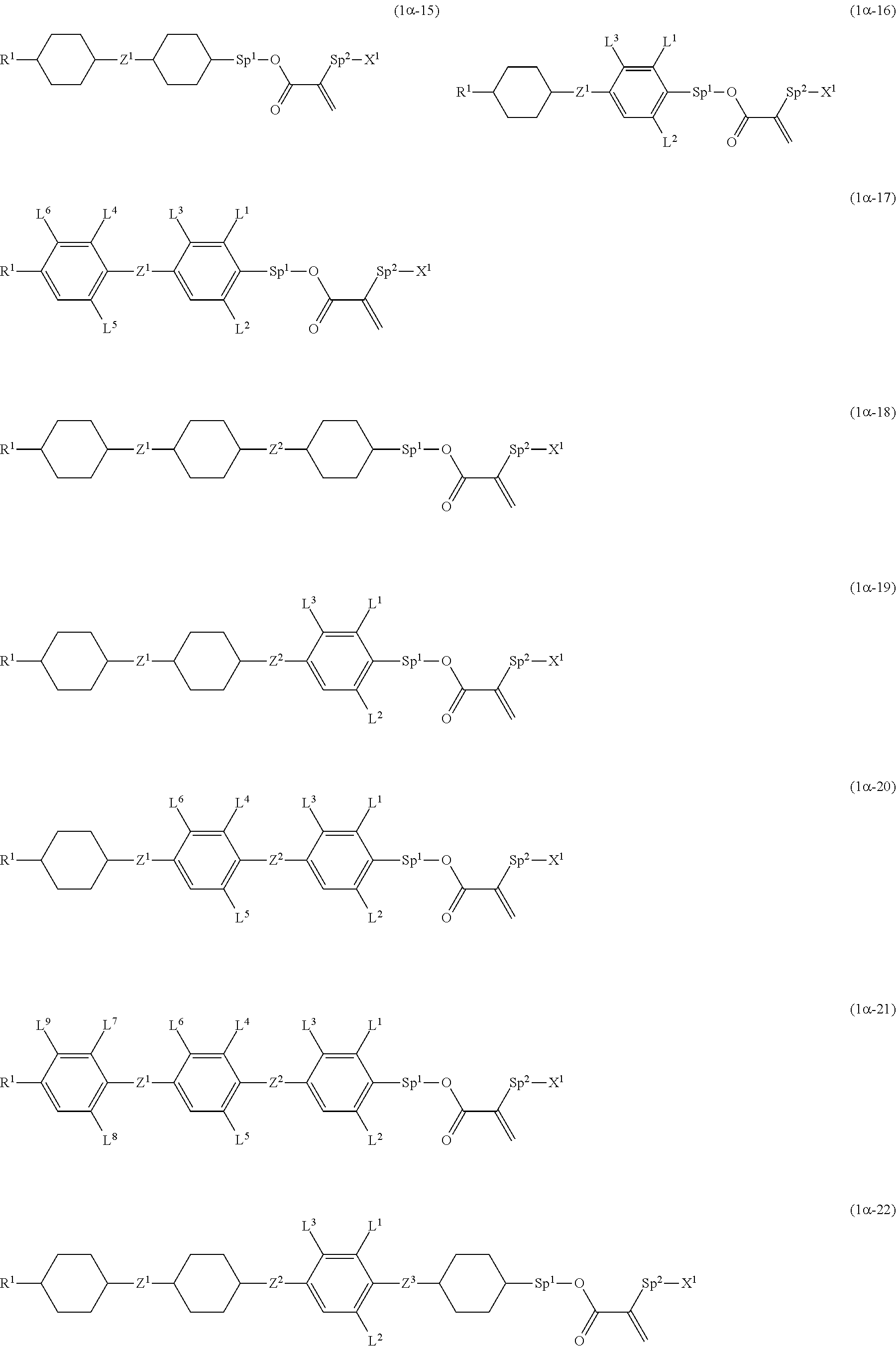

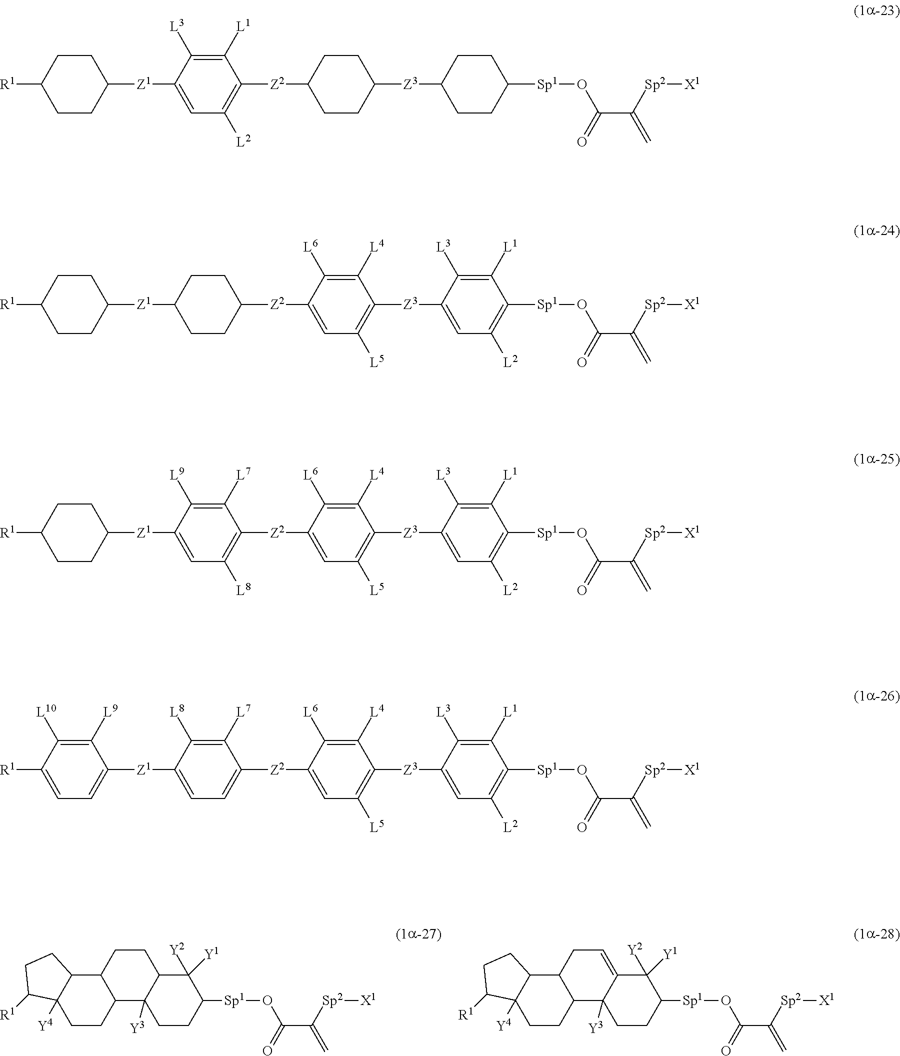

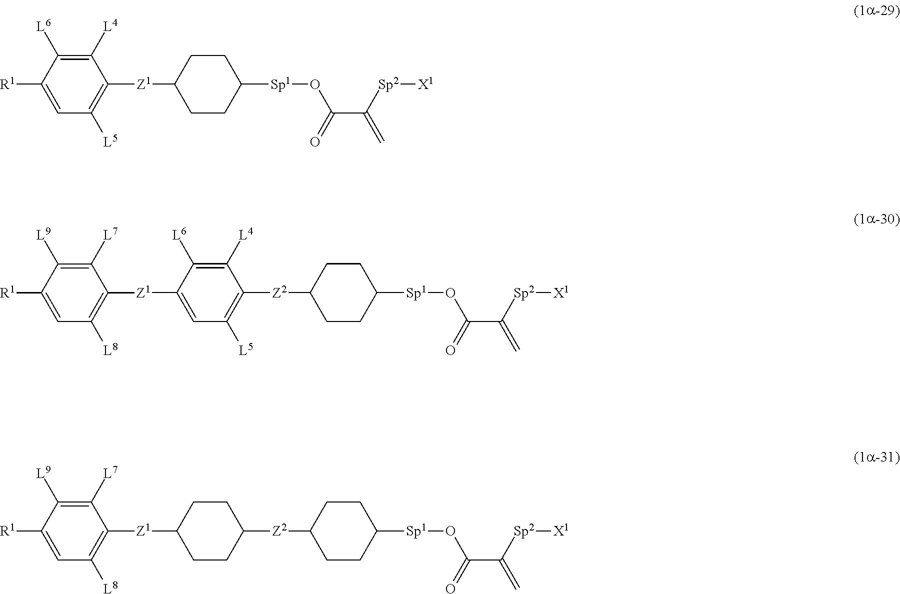

wherein, in formulas (1α-15) to (1α-31),

R¹ is alkyl having 1 to 10 carbons, alkenyl having 2 to 10 carbons or alkoxy having 1 to 9 carbons, and in the groups, at least one hydrogen may be replaced by fluorine;

Z¹, Z² and Z³ are independently a single bond or —(CH₂)₂—;

Sp¹ is a single bond or alkylene having 1 to 5 carbons, and in the alkylene, at least one —CH₂— may be replaced by —O—;

Sp² is alkylene having 1 to 5 carbons, and in the alkylene, at least one —CH₂— may be replaced by —O—;

L¹, L², L³, L⁴, L⁵, L⁶, L⁷, L⁸, L⁹ and L¹⁰ are independently hydrogen, fluorine, methyl or ethyl;

Y¹, Y², Y³ and Y⁴ are independently hydrogen or methyl; and

X¹ is —OH, —NH₂ or —N(R³)₂, in which R³ is hydrogen or alkyl having 1 to 4 carbons, and in the alkyl, at least one —CH₂— may be replaced by —O—, and in the groups, at least one hydrogen may be replaced by fluorine.

Item 8. The compound according to any one of items 1 to 7, represented by any one of formulas (1α-32) to (1α-43):

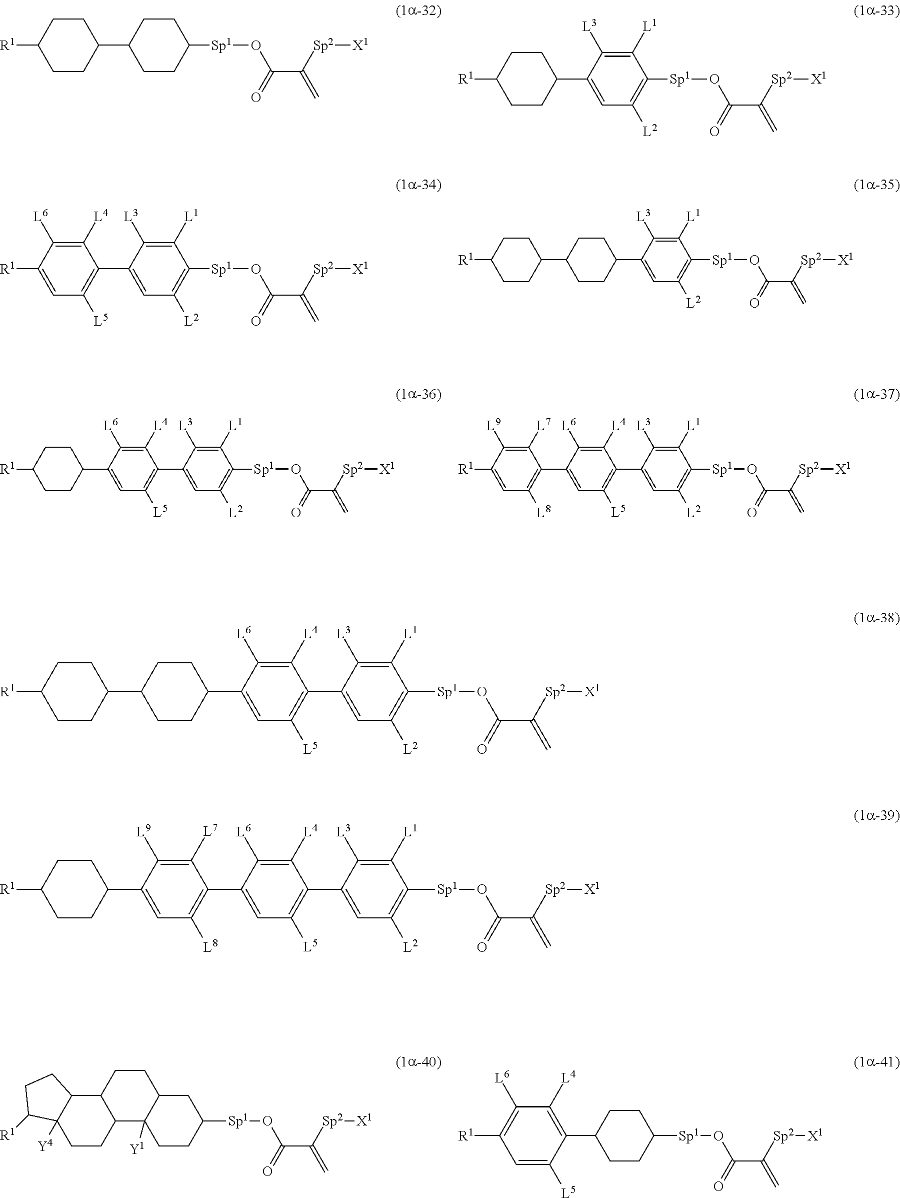

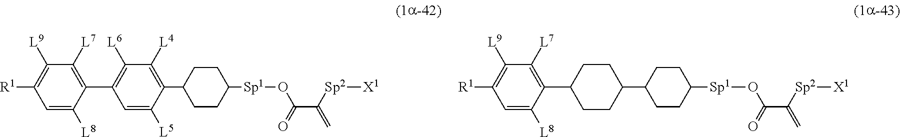

wherein, in formulas (1α-32) to (1α-43),

R¹ is alkyl having 1 to 10 carbons;

Sp¹ is a single bond or alkylene having 1 to 5 carbons, and in the alkylene, at least one —CH₂— may be replaced by —O—, and in the groups, at least one hydrogen may be replaced by fluorine;

Sp² is alkylene having 1 to 5 carbons, and in the alkylene, at least one —CH₂— may be replaced by —O—;

L¹, L², L³, L⁴, L⁵, L⁶, L⁷, L⁸ and L⁹ are independently hydrogen, fluorine, methyl or ethyl;

Y¹ and Y² are independently hydrogen or methyl; and

X¹ is —OH, —NH₂ or —N(R³)₂, in which R³ is hydrogen or alkyl having 1 to 4 carbons, and in the alkyl, at least one —CH₂— may be replaced by —O—.

Item 9. The compound according to any one of items 1 to 8, represented by any one of formulas (1α-44) to (1α-63):

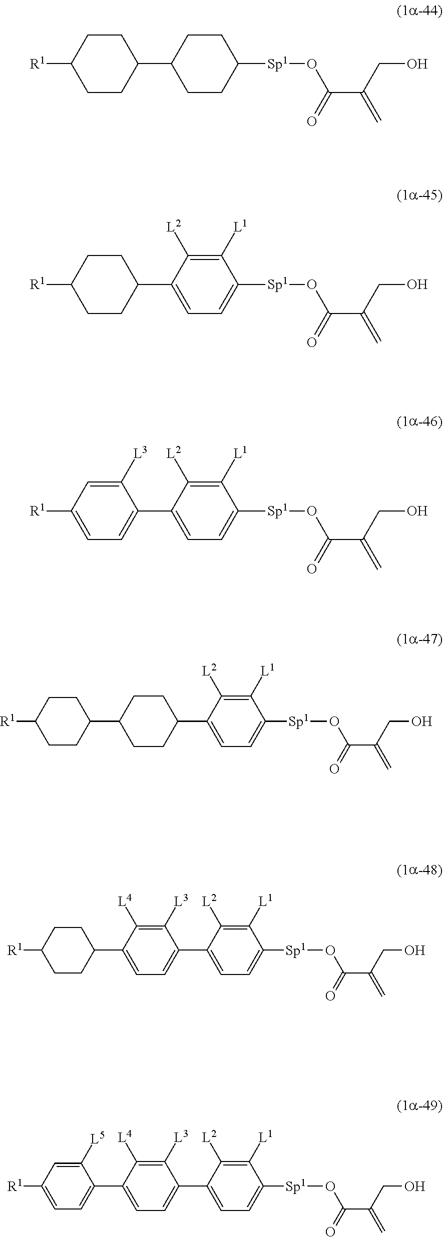

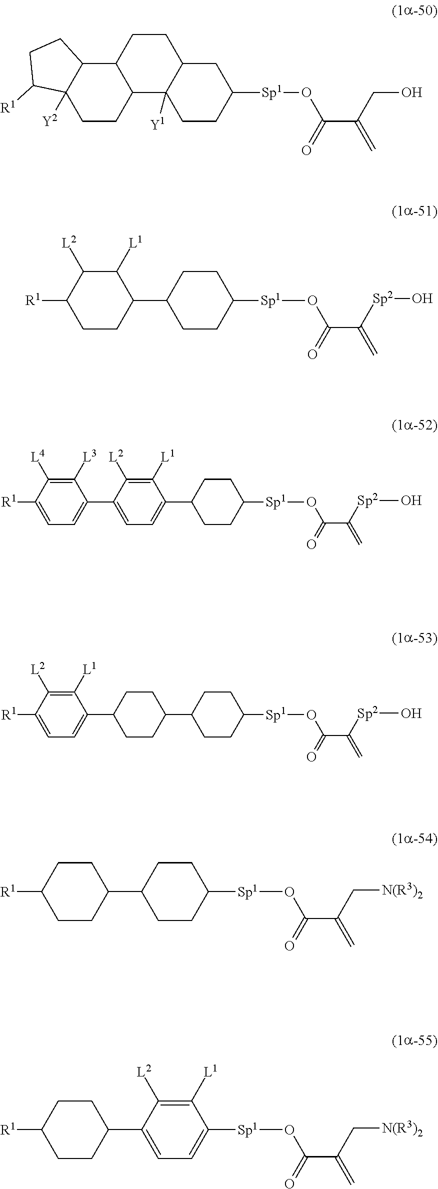

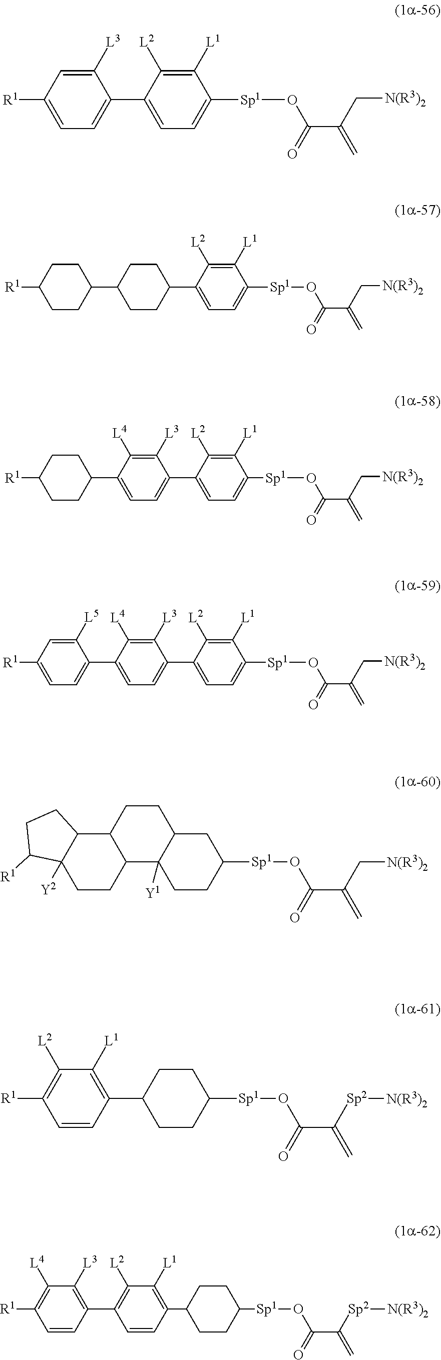

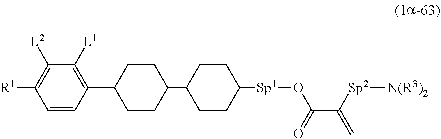

wherein, in formulas (1α-44) to (1α-63),

R¹ is alkyl having 1 to 10 carbons;

Sp¹ is a single bond or alkylene having 1 to 3 carbons, and in the alkylene, at least one —CH₂— may be replaced by —O—, and in the groups, at least one hydrogen may be replaced by fluorine;

Sp² is alkylene having 1 to 5 carbons, and in the alkylene, at least one —CH₂— may be replaced by —O—;

L¹, L², L³, L⁴ and L⁵ are independently hydrogen, fluorine, methyl or ethyl;

Y¹ and Y² are independently hydrogen or methyl; and

R³ is hydrogen, methyl or ethyl.

### 2. Form of Compound (1α)

Compound (1α) has features of having a mesogen moiety formed of at least one ring, and an acryloyloxy group in which replacement by a polar group such as a hydroxyalkyl group is made. Compound (1α) is useful because the polar group noncovalently interacts with a substrate surface. One of applications is as an additive for the liquid crystal composition used in the liquid crystal display device. Compound (1α) is added for the purpose of controlling alignment of liquid crystal molecules. Such an additive preferably has high chemical stability under conditions in which the additive is sealed in the device, high solubility in the liquid crystal composition, and a large voltage holding ratio when the composition is used in the liquid crystal display device. Compound (1α) satisfies such characteristics to a significant extent.

Preferred examples of compound (1α) will be described. Preferred examples of R¹, MES, Sp¹, R², M¹ or M² in compound (1α) are also applied to a subordinate formula of formula (1α) for compound (1α). In compound (1α), characteristics can be arbitrarily adjusted by suitably combining kinds of the groups. Compound (1α) may contain a larger amount of isotope such as ²H (deuterium) and ¹³C than an amount of natural abundance because no significant difference exists in the characteristics of the compound.

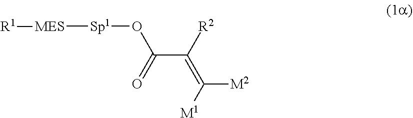

In formula (1α), R¹ is alkyl having 1 to 15 carbons, and in the alkyl, at least one —CH₂— may be replaced by —O— or —S—, at least one —(CH₂)₂— may be replaced by —CH═CH— or —C≡C—, and in the groups, at least one hydrogen may be replaced by halogen.

In formula (1α), preferred R¹ is alkyl having 1 to 15 carbons, alkenyl having 2 to 15 carbons, alkoxy having 1 to 14 carbons or alkenyloxy having 2 to 14 carbons. Further preferred R¹ is alkyl having 1 to 10 carbons, alkenyl having 2 to 10 carbons or alkoxy having 1 to 9 carbons. Particularly preferred R¹ is alkyl having 1 to 10 carbons.

In formula (1α), MES is a mesogen group having at least one ring. The mesogen group is well known by those skilled in the art. The mesogen group means a part that contributes to formation of a liquid crystal phase when the compound has the liquid crystal phase (mesophase). Preferred examples of compound (1α) include compound (1α-1).

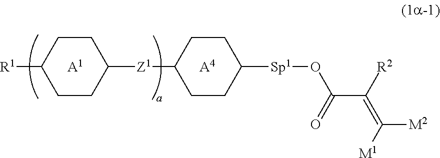

In formula (1α-1), preferred ring A¹ or ring A⁴ is 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine. Further preferred ring A¹ or ring A⁴ is 1,4-cyclohexylene, 1,4-phenylene, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons. Particularly preferred ring A¹ or ring A⁴ is 1,4-cyclohexylene, 1,4-phenylene or perhydrocyclopenta[a]phenanthrene-3,17-diyl, and in the rings, for example, as in 1-methyl-1,4-cyclohexylene, 2-ethyl-1,4-cyclohexylene and 2-fluoro-1,4-phenylene, at least one hydrogen may be replaced by fluorine, methyl or ethyl.

In formula (1α-1), Z¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen.

In formula (1α-1), preferred Z¹ is a single bond, —(CH₂)₂—, —CH═CH—, —C≡C—, —COO—, —OCO—, —CF₂O—, —OCF₂—, —CH₂O—, —OCH₂— or —CF═CF—. Further preferred Z¹ is a single bond, —(CH₂)₂— or —CH═CH—. Particularly preferred Z¹ is a single bond.

In formula (1α-1), a is 0, 1, 2, 3 or 4. Preferred a is 0, 1, 2 or 3. Further preferred a is 0, 1 or 2.

In formula (1α), Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen.

In formula (1α), preferred Sp¹ is a single bond, alkylene having 1 to 5 carbons, or alkylene having 1 to 5 carbons in which one —CH₂— is replaced by —O—. Further preferred Sp¹ is a single bond, alkylene having 1 to 3 carbons, or alkylene having 1 to 3 carbons in which one —CH₂— is replaced by —O—.

In formula (1α), M¹ and M² are independently hydrogen, halogen, alkyl having 1 to 5 carbons, or alkyl having 1 to 5 carbons in which at least one hydrogen is replaced by halogen. Preferred M¹ or M² is hydrogen, fluorine, methyl, ethyl or trifluoromethyl. Further preferred M¹ or M² is hydrogen.

In formula (1α), R² is a group represented by formula (1αa), (1αb) or (1αc). Preferred R² is a group represented by formula (1αa) or (1αb). Further preferred R² is a group represented by formula (1αa).

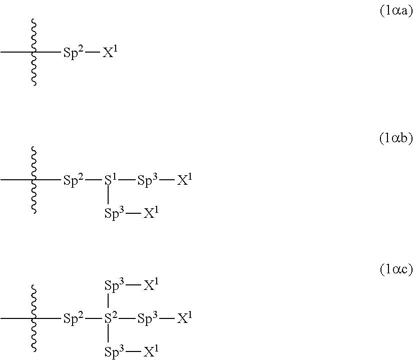

In formulas (1αa), (1αb) and (1αc), Sp² and Sp³ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen.

In formulas (1αa), (1αb) and (1αc), preferred Sp² or Sp³ is alkylene having 1 to 7 carbons, or alkylene having 1 to 5 carbons in which one —CH₂— is replaced by —O—. Further preferred Sp² or Sp³ is alkylene having 1 to 5 carbons, or alkylene having 1 to 5 carbons in which one —CH₂— is replaced by —O—. Particularly preferred Sp² or Sp³ is —CH₂—.

In formulas (1αa), (1αb) and (1αc), S¹ is >CH— or >N—; and S² is >C< or >Si<. Preferred S¹ is >CH— or >N—, and preferred S² is >C<. Formula (1b) is preferred to formula (1c).

In formulas (1αa), (1αb) and (1αc), X¹ is a group represented by —OH, —NH₂, —OR³, —N(R³)₂, formula (x1), —COOH, —SH, —B (OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen, and w in formula (x1) is 1, 2, 3 or 4.

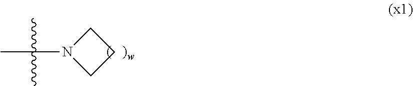

In formulas (1αa), (1αb) and (1αc), preferred X¹ is a group represented by —OH, —NH₂, —OR³, —N(R³)₂, formula (x1) or —Si(R³)₃, in which R³ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine, and w in formula (x1) is 1, 2, 3 or 4. Further preferred X¹ is —OH, —NH₂ or —N(R³)₂. Particularly preferred X¹ is —OH.

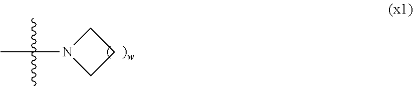

### 3. Synthesis of Compound (1α)

Synthesis methods of compound (1α) will be described. Compound (1α) can be synthesized by suitably combining methods in publicly-known synthetic organic chemistry. The synthesis methods may be applied with reference to books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

### 4. Example of Compound (1β)

Compound (1β) will be described as an example in the following items.

Item 21. A compound, represented by formula (1β):

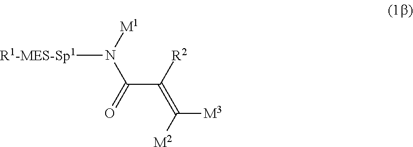

wherein, in formula (1β),

R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;

MES is a mesogen group having at least one ring;

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen; and

R², M¹, M² and M³ are independently hydrogen, halogen or alkyl having 1 to 10 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

Item 22. The compound according to item 21, represented by formula (1β-1):

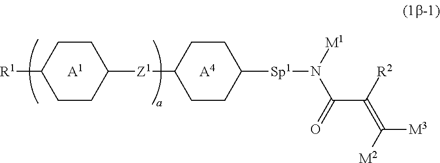

wherein, in formula (1β-1),

R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;

ring A¹ and ring A⁴ are independent 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;

Z¹ is a single bond or alkylene having 1 to 4 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

R², M¹, M² and M³ are independently hydrogen, halogen or alkyl having 1 to 8 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen; and

a is 0, 1, 2, 3 or 4; and

when a is 0 and ring A⁴ is 1,4-cyclohexylene or 1,4-phenylene, R¹ is alkyl having 5 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen; and

when a is 0 and ring A⁴ is perhydrocyclopenta[a]phenanthrene-3,17-diyl or 2,3,4,7,8,9,10,11,12,13,14,15,16,17-tetradecahydrocyclopenta[a]phenanthrene-3,17-diyl, M¹ is halogen or alkyl having 1 to 8 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

Item 23. The compound according to item 21 or 22, represented by any one of formulas (1β-3) to (1β-6):

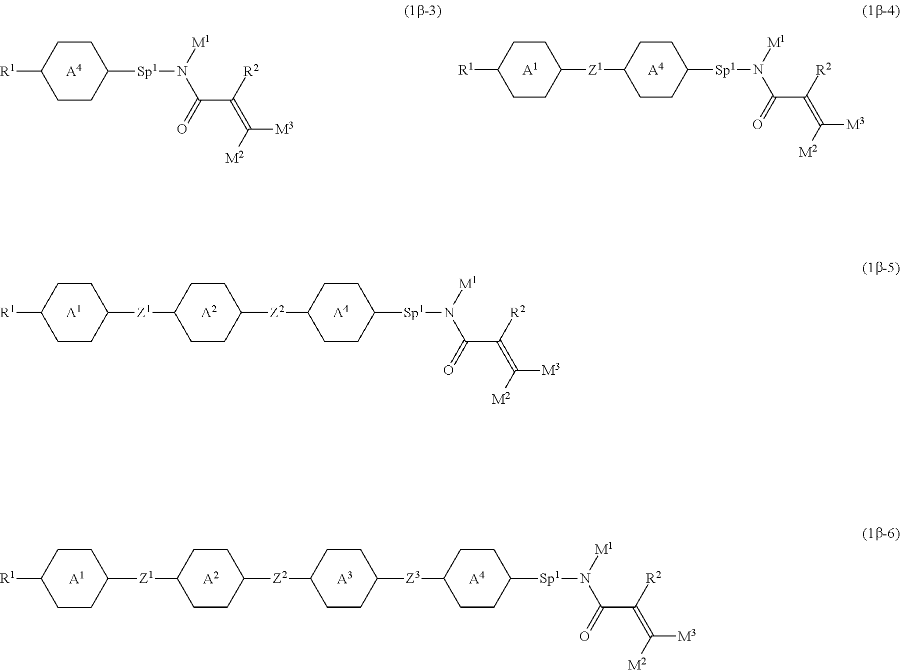

wherein, in formulas (1β-3) to (1β-6),

R¹ is alkyl having 1 to 15 carbons, alkenyl having 2 to 15 carbons, alkoxy having 1 to 14 carbons or alkenyloxy having 2 to 14 carbons, and in the groups, at least one hydrogen may be replaced by fluorine;

ring A¹, ring A², ring A³ and ring A⁴ are independently 1,4-cyclohexylene, 1,4-cyclohexenylene, 1,4-phenylene, naphthalene-2,6-diyl, decahydronaphthalene-2,6-diyl, tetrahydropyran-2,5-diyl, 1,3-dioxane-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 7 carbons, alkenyl having 2 to 7 carbons or alkoxy having 1 to 6 carbons;

Z¹, Z² and Z³ are independently a single bond, —(CH₂)₂—, —CH═CH—, —C≡C—, —COO—, —OCO—, —CF₂O—, —OCF₂—, —CH₂O—, —OCH₂— or —CF═CF—;

Sp¹ is a single bond or alkylene having 1 to 7 carbons, and in the alkylene, at least one —CH₂— may be replaced by —O—, —COO— or —OCO—, and at least one —(CH₂)₂— may be replaced by —CH═CH—, and in the groups, at least one hydrogen may be replaced by fluorine; and

R², M¹, M² and M³ are independently hydrogen or alkyl having 1 to 8 carbons, and in the alkyl, at least one —CH₂— may be replaced by —O—, and at least one —(CH₂)₂— may be replaced by —CH═CH—, and in the groups, at least one hydrogen may be replaced by fluorine or chlorine; and

in formula (1β-3), when ring A⁴ is 1,4-cyclohexylene or 1,4-phenylene, R¹ is alkyl having 5 to 15 carbons, alkenyl having 5 to 15 carbons, alkoxy having 4 to 14 carbons or alkenyloxy having 4 to 14 carbons, and in the groups, at least one hydrogen may be replaced by fluorine; and

in formula (1β-3), when ring A⁴ is perhydrocyclopenta[a]phenanthrene-3,17-diyl or 2,3,4,7,8,9,10,11,12,13,14,15,16,17-tetradecahydrocyclopenta[a]phenanthrene-3,17-diyl, M¹ is alkyl having 1 to 8 carbons, and in the alkyl, at least one —CH₂— may be replaced by —O—, and at least one —(CH₂)₂— may be replaced by —CH═CH—, and in the groups, at least one hydrogen may be replaced by fluorine or chlorine.

Item 24. The compound according to any one of items 21 to 23, represented by any one of formulas (1β-3) to (1β-6):

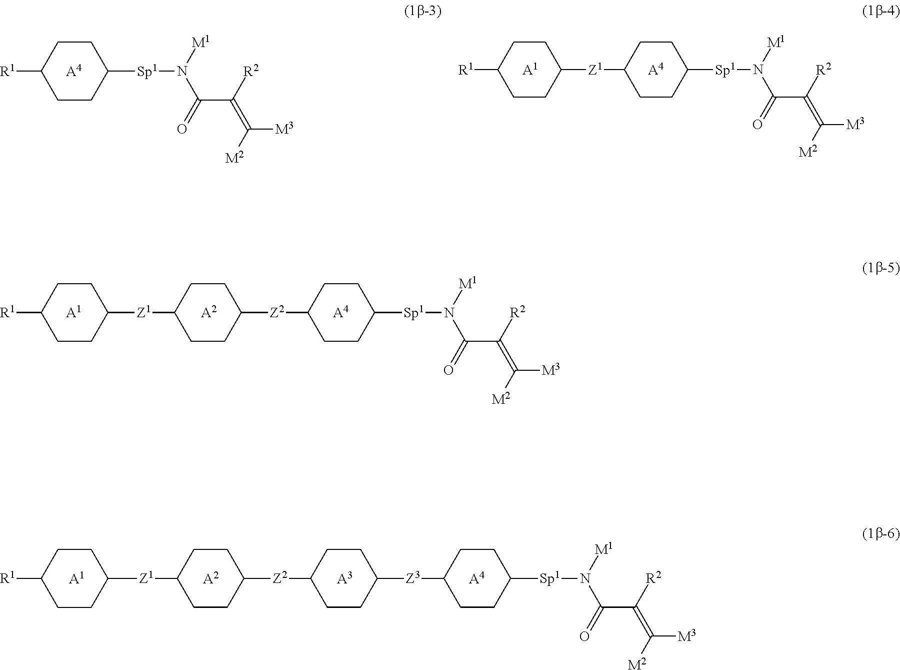

wherein, in formulas (1β-3) to (1β-6),

M² and M³ are hydrogen;

R¹ is alkyl having 1 to 10 carbons, alkenyl having 2 to 10 carbons or alkoxy having 1 to 9 carbons;

ring A¹, ring A², ring A³ and ring A⁴ are independently 1,4-cyclohexylene, 1,4-phenylene, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons;

Z¹, Z² and Z³ are independently a single bond or —(CH₂)₂—;

Sp¹ is a single bond or alkylene having 1 to 5 carbons, and in the alkylene, at least one —CH₂— may be replaced by —O—; and

M¹ and R² are independently hydrogen or alkyl having 1 to 5 carbons, and in the alkyl, at least one —CH₂— may be replaced by —O—; and

in formula (1β-3), when ring A⁴ is 1,4-cyclohexylene or 1,4-phenylene, R¹ is alkyl having 5 to 10 carbons, alkenyl having 5 to 10 carbons or alkoxy having 4 to 9 carbons; and

in formula (1β-3), when ring A⁴ is perhydrocyclopenta[a]phenanthrene-3,17-diyl or 2,3,4,7,8,9,10,11,12,13,14,15,16,17-tetradecahydrocyclopenta[a]phenanthrene-3,17-diyl, M¹ is alkyl having 1 to 5 carbons, and in the alkyl, at least one —CH₂— may be replaced by —O—.

Item 25. The compound according to any one of items 21 to 24, represented by any one of formulas (1β-7) to (1β-20):

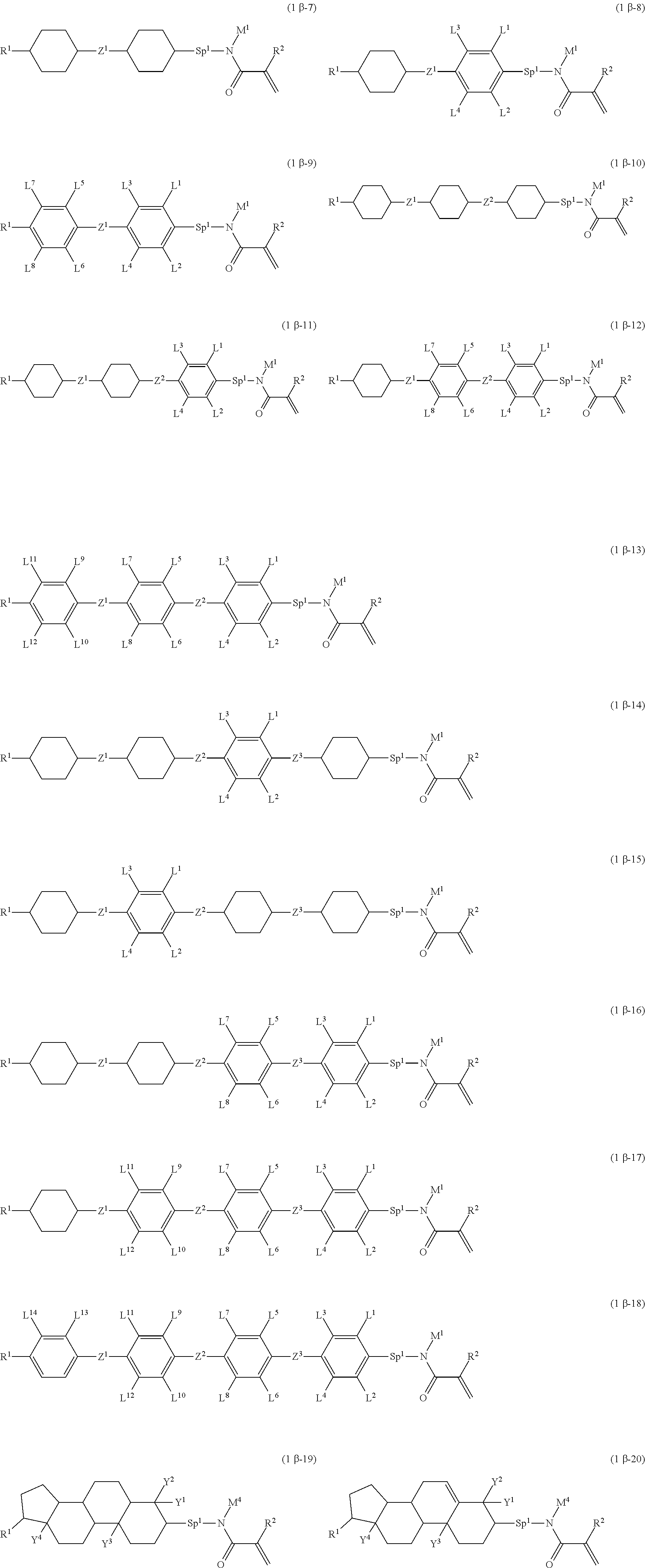

wherein, in formulas (1β-7) to (1β-20),

R¹ is alkyl having 1 to 10 carbons, alkenyl having 2 to 10 carbons or alkoxy having 1 to 9 carbons;

Z¹, Z² and Z³ are independently a single bond or —(CH₂)₂—;

Sp¹ is a single bond or alkylene having 1 to 5 carbons, and in the alkylene, at least one —CH₂— may be replaced by —O—;

L¹, L², L³, L⁴, L⁵, L⁶, L⁷, L⁸, L⁹, L¹⁰, L¹¹, L¹², L¹³ and L¹⁴ are independently hydrogen, fluorine, methyl or ethyl;

Y¹, Y², Y³ and Y⁴ are independently hydrogen or methyl, and M¹ is hydrogen or alkyl having 1 to 5 carbons;

M⁴ is alkyl having 1 to 5 carbons; and

R² is hydrogen, methyl or ethyl.

Item 26. The compound according to any one of items 21 to 24, represented by any one of formulas (1β-21) to (1β-29):

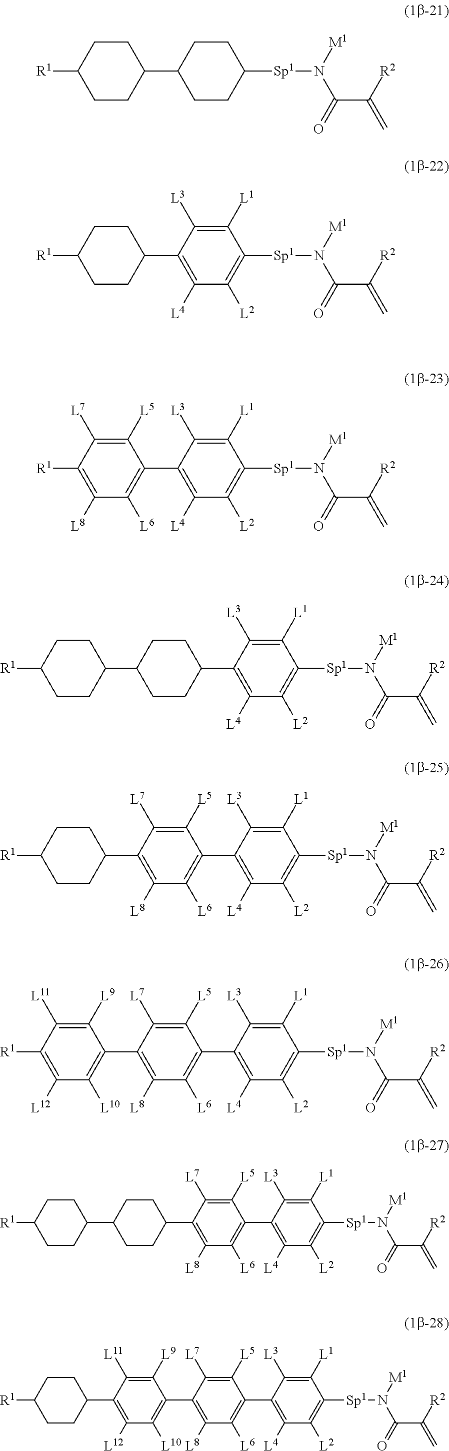

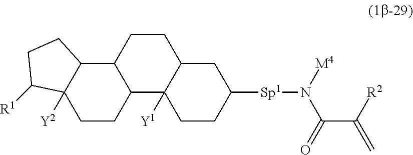

wherein, in formulas (1β-21) to (1β-29),

R¹ is alkyl having 1 to 10 carbons;

Sp¹ is a single bond or alkylene having 1 to 5 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine, methyl or ethyl;

Y¹ and Y² are independently hydrogen or methyl, and

M¹ is hydrogen, methyl or ethyl;

M⁴ is methyl or ethyl; and

R² is hydrogen or methyl.

Item 27. The compound according to any one of items 21 to 24, represented by any one of formulas (1β-30) to (1β-36):

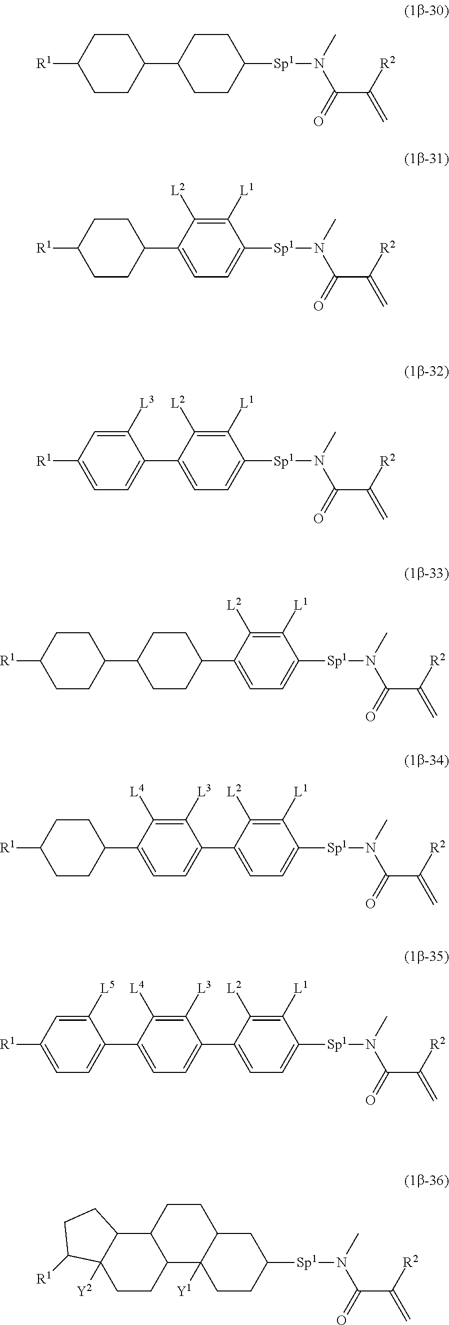

wherein, in formulas (1β-30) to (1β-36),

R¹ is alkyl having 1 to 10 carbons;

Sp¹ is a single bond or alkylene having 1 to 3 carbons, and in the alkylene, at least one —CH₂— may be replaced by —O—;

L¹, L², L³, L⁴ and L⁵ are independently hydrogen, fluorine, methyl or ethyl;

Y¹ and Y² are independently hydrogen or methyl; and

R² is hydrogen or methyl.

### 5. Form of Compound (1β)

Compound (1β) has features of having a mesogen moiety formed of at least one ring, and an acrylamide group. Compound (1β) is useful because a polar group noncovalently interacts with a substrate surface. One of applications is as an additive for the liquid crystal composition used in the liquid crystal display device. Compound (1β) is added for the purpose of controlling alignment of liquid crystal molecules. Such an additive preferably has high chemical stability under conditions in which the additive is sealed in the device, high solubility in the liquid crystal composition, and the large voltage holding ratio when the liquid crystal composition is used in the liquid crystal display device. Compound (1β) satisfies such characteristics to a significant extent.

Preferred examples of compound (1β) will be described. Preferred examples of R¹, MES, Sp¹, M¹, R², M² or M³ in compound (1β) are also applied to a subordinate formula of formula (1β) for compound (1β). In compound (1β), characteristics can be arbitrarily adjusted by suitably combining kinds of the groups. Compound (1β) may contain a larger amount of isotope such as ²H (deuterium) and ¹³C than an amount of natural abundance because no significant difference exists in the characteristics of the compound.

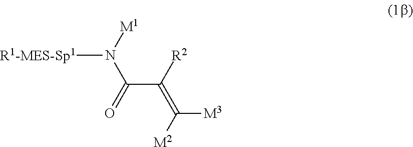

In formula (1β), R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

In formula (1β), preferred R¹ is alkyl having 1 to 15 carbons, alkenyl having 2 to 15 carbons, alkoxy having 1 to 14 carbons or alkenyloxy having 2 to 14 carbons. Further preferred R¹ is alkyl having 1 to 10 carbons, alkenyl having 2 to 10 carbons or alkoxy having 1 to 9 carbons. Particularly preferred R¹ is alkyl having 1 to 10 carbons.

In formula (1β), MES is a mesogen group having at least one ring. The mesogen group is well known by those skilled in the art. The mesogen group means the part that contributes to formation of the liquid crystal phase when the compound has the liquid crystal phase (mesophase). Preferred examples of compound (1β) include compound (1β-1).

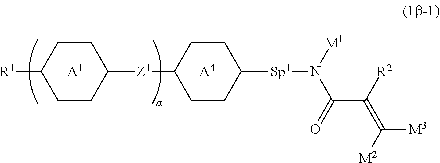

In formula (1β-1), preferred ring A¹ or ring A⁴ is 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine. Further preferred ring A¹ or ring A⁴ is 1,4-cyclohexylene, 1,4-phenylene, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons. Particularly preferred ring A¹ or ring A⁴ is 1,4-cyclohexylene, 1,4-phenylene or perhydrocyclopenta[a]phenanthrene-3,17-diyl, and in the rings, at least one hydrogen may be replaced by fluorine, methyl or ethyl.

In formula (1β-1), Z¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen.

In formula (1β-1), preferred Z¹ is a single bond, —(CH₂)₂—, —CH═CH—, —C≡C—, —COO—, —OCO—, —CF₂O—, —OCF₂—, —CH₂O—, —OCH₂— or —CF═CF—. Further preferred Z¹ is a single bond, —(CH₂)₂— or —CH═CH—. Particularly preferred Z¹ is a single bond.

In formula (1β-1), a is 0, 1, 2, 3 or 4. Preferred a is 0, 1, 2 or 3. Further preferred a is 0, 1 or 2.

In formula (1β), Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen.

In formula (1β), preferred Sp¹ is a single bond, alkylene having 1 to 5 carbons, or alkylene having 1 to 5 carbons in which one —CH₂— is replaced by —O—. Further preferred Sp¹ is a single bond, alkylene having 1 to 3 carbons, or alkylene having 1 to 3 carbons in which one —CH₂— is replaced by —O—.

In formula (1β), M² and M³ are independently hydrogen, halogen, alkyl having 1 to 5 carbons, or alkyl having 1 to 5 carbons in which at least one hydrogen is replaced by halogen. Preferred M² or M³ is hydrogen, fluorine, methyl, ethyl or trifluoromethyl. Further preferred M² or M³ is hydrogen.

In formula (1β), R² is hydrogen, halogen, alkyl having 1 to 5 carbons, or alkyl having 1 to 5 carbons in which at least one hydrogen is replaced by halogen. Preferred R² is hydrogen, methyl and ethyl. Further preferred R² is hydrogen.

In formula (1β), M¹ is hydrogen, halogen, alkyl having 1 to 5 carbons, or alkyl having 1 to 5 carbons in which at least one hydrogen is replaced by halogen. Preferred M¹ is hydrogen, fluorine, methyl, ethyl or trifluoromethyl. Further preferred M¹ is methyl.

### 6. Synthesis of Compound (1β)

Synthesis methods of compound (1β) will be described. Compound (1β) can be synthesized by suitably combining methods in publicly-known synthetic organic chemistry. The synthesis methods may be applied with reference to books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

### 7. Example of Compound (1γ)

Compound (1γ) will be described as an example in the following items.

Item 41. A compound, represented by formula (1γ):

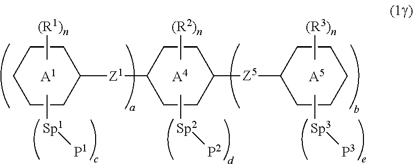

wherein, in formula (1γ),

R¹, R² and R³ are independently hydrogen or alkyl having 1 to 15 carbons, and in the alkyl, at least one —CH₂— may be replaced by —O—, —S— or —NH—, and at least one —(CH₂)₂— may be replaced by —CH═CH—, and in the groups, at least one hydrogen may be replaced by halogen;

n is independently 0, 1 or 2;

ring A⁴ is cyclohexylene, cyclohexenylene, phenylene, naphthalene, decahydronaphthalene, tetrahydronaphthalene, tetrahydropyran, 1,3-dioxane, pyrimidine or pyridine, and ring A¹ and ring A⁵ are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and

in the rings, at least one hydrogen may be replaced by fluorine, chlorine, alkenyl having 2 to 12 carbons, alkoxy having 1 to 11 carbons or alkenyloxy having 2 to 11 carbons, and in the groups, at least one hydrogen may be replaced by fluorine or chlorine;

Z¹ and Z⁵ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine;

Sp¹, Sp² and Sp³ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine;

a and b are independently 0, 1, 2, 3 or 4, and a sum of a and b is 1, 2, 3 or 4;

c, d and e are independently 0, 1, 2, 3 or 4;

a sum of c, d and e is 2, 3 or 4; and

P¹, P² and P³ are independently a polymerizable group represented by formula (P-1):

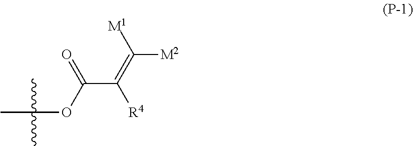

wherein, in formula (P-1),

M¹ and M² are independently hydrogen, halogen, alkyl having 1 to 5 carbons, or alkyl having 1 to 5 carbons in which at least one hydrogen is replaced by halogen; and

R⁴ is a group selected from the group of groups represented by formulas (1γa), (1γb) and (1γc):

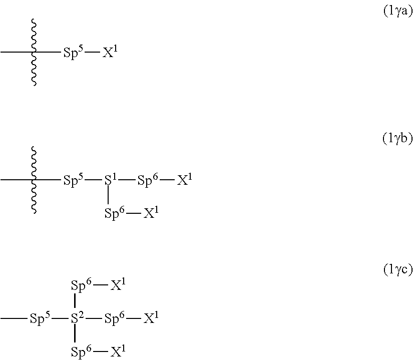

wherein, in formulas (1γa), (1γb) and (1γc),

Sp⁵ and Sp⁶ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

S¹ is >CH— or >N—;

S² is >C< or >Si<; and

X¹ is independently a group represented by —OH, —NH₂, —OR⁵, —N(R⁵)₂, —COOH, —SH, —B(OH)₂ or —Si(R⁵)₃, in which R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen.

Item 42. The compound according to item 41, wherein, in formula (P-1), R⁴ is a group represented by formula (1γa) or (1γb).

Item 43. The compound according to item 41 or 42, wherein, in formula (1γ), R⁴ is represented by formula (1γa), c, d and e are 0, 1, 2 or 3, and a sum of c, d and e is 2, 3 or 4.

Item 44. The compound according to any one of items 41 to 43, represented by any one of formulas (1γ-1) to (1γ-6):

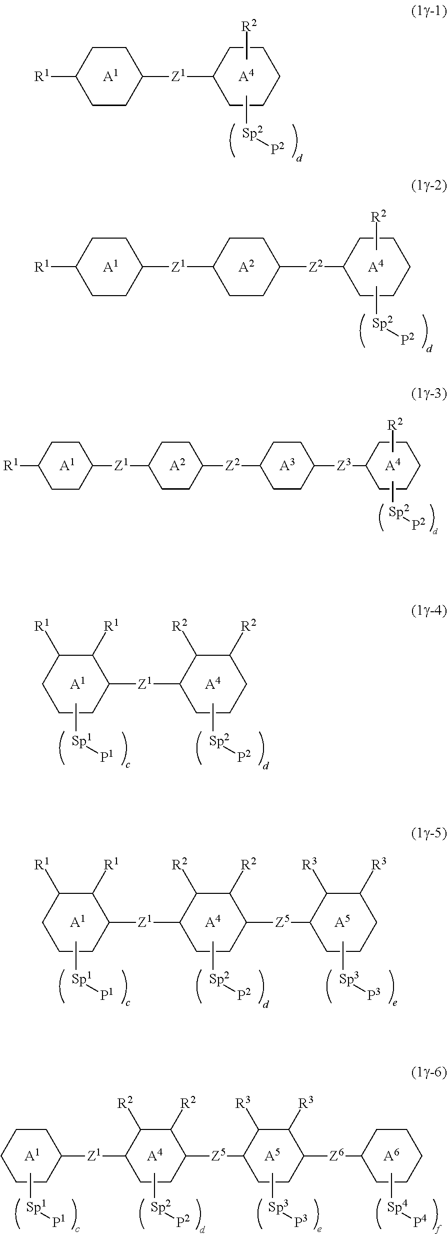

wherein, in formulas (1γ-1) to (1γ-6),

R¹, R² and R³ are independently hydrogen, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine;

ring A¹, ring A², ring A³, ring A⁴, ring A⁵ and ring A⁶ are independently cyclohexylene, cyclohexenylene, phenylene, naphthalene, tetrahydropyran or 1,3-dioxane, and in the rings, at least one hydrogen may be replaced by fluorine, chlorine, alkyl having 1 to 10 carbons, alkenyl having 2 to 10 carbons, alkoxy having 1 to 9 carbons or alkenyloxy having 2 to 9 carbons, and in the groups, at least one hydrogen may be replaced by fluorine or chlorine;

Z¹, Z², Z³, Z⁵ and Z⁶ are independently a single bond or alkylene having 1 to 8 carbons, and in the alkylene, at least one —CH₂— may be replaced by —O—, —COO— or —OCO—, and at least one —(CH₂)₂— may be replaced by —CH═CH— or —C≡C—, and in the groups, at least one hydrogen may be replaced by fluorine or chlorine;

Sp¹, Sp², Sp³ and Sp⁴ are independently a single bond or alkylene having 1 to 8 carbons, and in the alkylene, at least one —CH₂— may be replaced by —O—, —COO— or —OCO—, and at least one —(CH₂)₂— may be replaced by —CH═CH— or —C≡C—, and in the groups, at least one hydrogen may be replaced by fluorine or chlorine;

c, d, e and f are independently 0, 1, 2 or 3, and a sum of c, d, e and f is 2, 3 or 4, in which, in formulas (1γ-1) to (1γ-3), d is 2 or 3; and

P¹, P², P³ and P⁴ are independently a polymerizable group represented by formula (P-1):

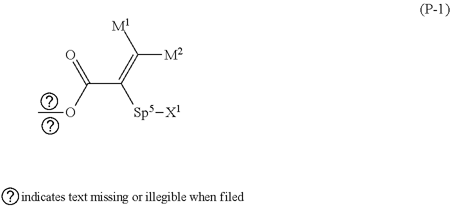

wherein, in formula (P-1),

M¹ and M² are independently hydrogen, halogen, alkyl having 1 to 4 carbons, or alkyl having 1 to 4 carbons in which at least one hydrogen is replaced by halogen;

Sp⁵ is a single bond or alkylene having 1 to 8 carbons, and in the alkylene, at least one —CH₂— may be replaced by —O—, —CO—, —COO— or —OCO—, and at least one —(CH₂)₂— may be replaced by —CH═CH— or —C≡C—, and in the groups, at least one hydrogen may be replaced by halogen; and

X¹ is a group represented by —OH, —NH₂, —OR⁵, —N(R⁵)₂ or —Si(R⁵)₃, in which R⁵ is hydrogen or alkyl having 1 to 8 carbons, and in the alkyl, at least one —CH₂— may be replaced by —O—, and at least one —(CH₂)₂— may be replaced by —CH═CH—, and in the groups, at least one hydrogen may be replaced by halogen.

Item 45. The compound according to item 44, wherein, in formulas (1γ-1) to (1γ-6),

R¹, R² and R³ are independently hydrogen, alkyl having 1 to 10 carbons, alkenyl having 2 to 10 carbons, alkoxy having 1 to 9 carbons or alkenyloxy having 2 to 9 carbons, and in the groups, at least one hydrogen may be replaced by fluorine;

ring A¹, ring A², ring A³, ring A⁴, ring A⁵ and ring A⁶ are independently cyclohexylene, cyclohexenylene, phenylene, naphthalene or tetrahydropyran, and in the rings, at least one hydrogen may be replaced by fluorine, chlorine, alkyl having 1 to 6 carbons, alkenyl having 2 to 6 carbons or alkoxy having 2 to 5 carbons, and in the groups, at least one hydrogen may be replaced by fluorine or chlorine;

Z¹, Z², Z³, Z⁵ and Z⁶ are independently a single bond or alkylene having 1 to 6 carbons, and in the alkylene, at least one —CH₂— may be replaced by —O—, —COO— or —OCO—, and at least one —(CH₂)₂— may be replaced by —CH═CH— or —C≡C—, and in the groups, at least one hydrogen may be alternatively replaced by fluorine;

Sp¹, Sp², Sp³ and Sp⁴ are independently a single bond or alkylene having 1 to 6 carbons, and in the alkylene, at least one —CH₂— may be replaced by —O—, and at least one —(CH₂)₂— may be replaced by —CH═CH—, and in the groups, at least one hydrogen may be replaced by fluorine;

c, d, e and f are independently 0, 1, 2 or 3, and a sum of c, d, e and f is 2, 3 or 4, in which, in formulas (1γ-1) to (1γ-3), d is 2 or 3; and

P¹, P², P³ and P⁴ are independently a polymerizable group represented by formula (P-1):

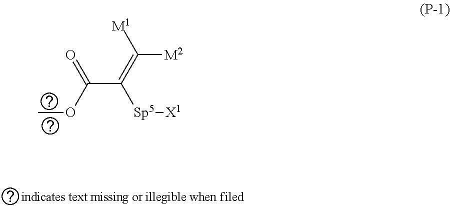

wherein, in formula (P-1),

M¹ and M² are independently hydrogen, alkyl having 1 to 3 carbons, or alkyl having 1 to 3 carbons in which at least one hydrogen is replaced by halogen; and

Sp⁵ is a single bond or alkylene having 1 to 6 carbons, and in the alkylene, at least one —CH₂— may be replaced by —O—, and at least one —(CH₂)₂— may be replaced by —CH═CH— or —C≡C—, and in the groups, at least one hydrogen may be replaced by fluorine, and

X¹ is a group represented by —OH and —NH₂.

Item 46. The compound according to any one of items 41 to 45, represented by any one of formulas (1γ-7) to (1γ-21):

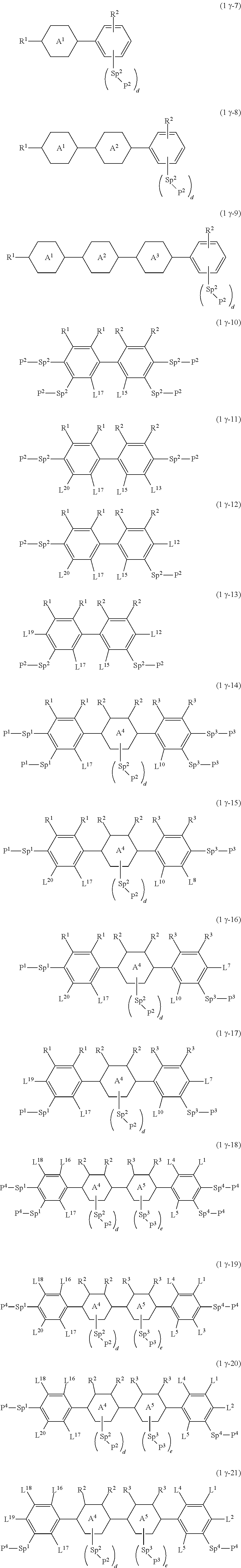

wherein, in formulas (1γ-7) to (1γ-21),

R¹, R² and R³ are independently hydrogen, alkyl having 1 to 8 carbons, alkenyl having 2 to 8 carbons, alkoxy having 1 to 7 carbons or alkenyloxy having 2 to 7 carbons;

ring A¹, ring A², ring A³, ring A⁴ and ring A⁵ are independently cyclohexylene, cyclohexenylene or phenylene, and in the rings, at least one hydrogen may be replaced by fluorine, chlorine, alkyl having 1 to 5 carbons, alkenyl having 2 to 5 carbons or alkoxy having 1 to 4 carbons, and in the groups, at least one hydrogen may be replaced by fluorine;

L¹, L², L³, L⁴, L⁵, L⁷, L⁸, L¹⁰, L¹², L¹³, L¹⁵, L¹⁶, L¹⁷, L¹⁸, L¹⁹ and L²⁰ are independently fluorine, methyl or ethyl;

Sp¹, Sp², Sp³ and Sp⁴ are independently a single bond or alkylene having 1 to 5 carbons, and in the alkylene, at least one —CH₂— may be replaced by —O—;

c, d, e and f are independently 0, 1 or 2, and a sum of c, d, e and f is 2, 3 or 4, in which, in formulas (1γ-7) to (1γ-9), d is 2; and

P¹, P², P³ and P⁴ are independently a polymerizable group represented by formula (P-1):

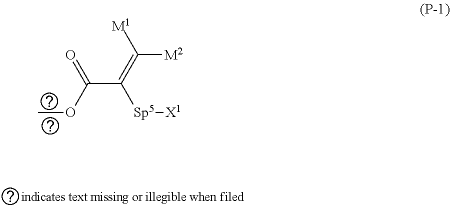

wherein, in formula (P-1),

M¹ and M² are independently hydrogen, fluorine, methyl, ethyl or trifluoromethyl;

Sp⁵ is a single bond or alkylene having 1 to 5 carbons, and in the alkylene, at least one —CH₂— may be replaced by —O—; and

X¹ is a group represented by —OH and —NH₂.

Item 47. In formulas (1γ-7) to (1γ-21), R¹, R² and R³ are independently hydrogen, alkyl having 1 to 8 carbons, alkenyl having 2 to 8 carbons, alkoxy having 1 to 7 carbons or alkenyloxy having 2 to 7 carbons;

ring A¹, ring A², ring A³, ring A⁴ and ring A⁵ are independently cyclohexylene, cyclohexenylene or phenylene, and in the rings, at least one hydrogen may be replaced by fluorine, alkyl having 1 to 3 carbons, alkenyl having 2 to 3 carbons or alkoxy having 1 to 2 carbons, and in the groups, at least one hydrogen may be replaced by fluorine;

L¹, L², L³, L⁴, L⁵, L⁷, L⁸, L¹⁰, L¹², L¹³, L¹⁵, L¹⁶, L¹⁷, L¹⁸, L¹⁹ and L²⁰ are independently fluorine, methyl or ethyl;

Sp¹, Sp², Sp³ and Sp⁴ are independently a single bond or alkylene having 1 to 5 carbons, and in the alkylene, at least one —CH₂— may be replaced by —O—;

c, d, e and f are independently 0, 1 or 2, and a sum of c, d, e and f is 2, 3 or 4, in which, in formulas (1γ-7) to (1γ-9), d is 2; and

P¹, P², P³ and P⁴ are independently a polymerizable group represented by formula (P-1):

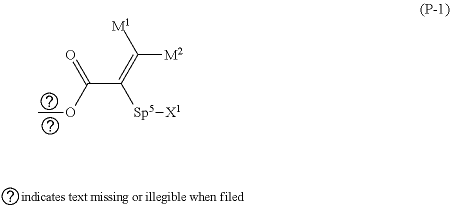

wherein, in formula (P-1),

M¹ and M² are independently hydrogen, fluorine, methyl or ethyl;

Sp⁵ is a single bond or alkylene having 1 to 5 carbons, and in the alkylene, at least one —CH₂— may be replaced by —O—; and

X¹ is a group represented by —OH and —NH₂.

Item 48. The compound according to any one of items 41 to 47, represented by any one of formulas (1γ-22) to (1γ-34):

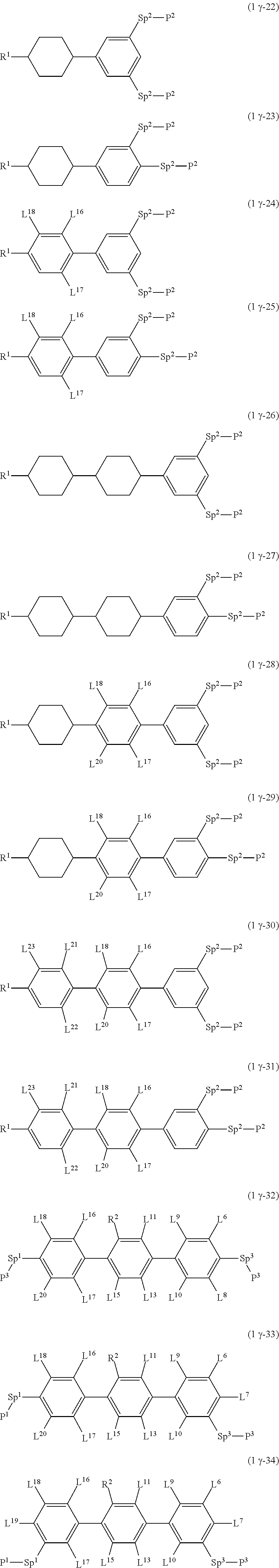

wherein, in formulas (1γ-22) to (1γ-34),

R¹ and R² are alkyl having 1 to 7 carbons, alkenyl having 2 to 7 carbons, alkoxy having 1 to 6 carbons or alkenyloxy having 2 to 6 carbons;

L⁶, L⁷, L⁸, L⁹, L¹⁰, L¹¹, L¹³, L¹⁵, L¹⁶, L¹⁷, L¹⁸, L¹⁹, L²⁰, L²¹, L²² and L²³ are independently hydrogen, fluorine, methyl or ethyl;

Sp¹, Sp² and Sp³ are independently a single bond or alkylene having 1 to 3 carbons, and in the alkylene, at least one —CH₂— may be replaced by —O—; and

P¹, P² and P³ are independently a polymerizable group represented by formula (P-1):

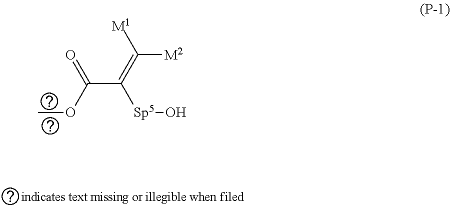

wherein, in formula (P-1),

M¹ and M² are independently hydrogen, fluorine or methyl; and

Sp⁵ is a single bond or alkylene having 1 to 3 carbons, and in the alkylene, at least one —CH₂— may be replaced by —O—.

### 8. Form of Compound (1γ)

Compound (1γ) has features of having a mesogen moiety formed of at least one ring, and a plurality of polar groups. Compound (1γ) is useful because the polar group noncovalently interacts with a substrate surface. One of applications is as an additive for the liquid crystal composition used in the liquid crystal display device. Compound (1γ) is added for the purpose of controlling alignment of liquid crystal molecules. Such an additive preferably has high chemical stability under conditions in which the additive is sealed in the device, high solubility in the liquid crystal composition, and the large voltage holding ratio when the liquid crystal composition is used in the liquid crystal display device. Compound (1γ) satisfies such characteristics to a significant extent.

Preferred examples of compound (1γ) will be described. Preferred examples of R¹, R², R², R³, Z¹, Z², Z³, A¹, A⁴, A⁵, Sp¹, Sp², Sp³, P¹, P² or P³ are also applied to a subordinate formula of formula (1γ) for compound (1γ). In compound (1γ), characteristics can be arbitrarily adjusted by suitably combining kinds of the groups. Compound (1γ) may contain a larger amount of isotope such as ²H (deuterium) and ¹³C than an amount of natural abundance because no significant difference exists in the characteristics of the compound.

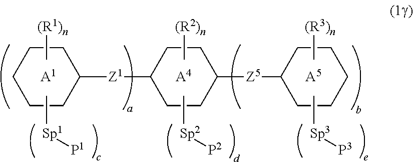

In formula (1γ), R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

In formula (1γ), preferred R¹ is alkyl having 1 to 15 carbons, alkenyl having 2 to 15 carbons, alkoxy having 1 to 14 carbons or alkenyloxy having 2 to 14 carbons. Further preferred R¹ is alkyl having 1 to 10 carbons, alkenyl having 2 to 10 carbons or alkoxy having 1 to 9 carbons. Particularly preferred R¹ is alkyl having 1 to 10 carbons.

In formula (1γ), ring A¹, ring A⁴ and ring A⁵ are independently cyclohexylene, cyclohexenylene, phenylene, naphthalene, decahydronaphthalene, tetrahydronaphthalene, tetrahydropyran, 1,3-dioxane, pyrimidine or pyridine, and in the rings, at least one hydrogen may be replaced by halogen, alkyl having 1 to 12 carbons, alkoxy having 1 to 12 carbons, or alkyl having 1 to 12 carbons in which at least one hydrogen is replaced by halogen.

In formula (1γ), preferred ring A¹, ring A⁴ or ring A⁵ is cyclohexylene, cyclohexenylene, phenylene, naphthalene, tetrahydropyran or 1,3-dioxane, and in the rings, at least one hydrogen may be replaced by fluorine, chlorine, alkyl having 1 to 5 carbons or alkoxy having 1 to 4 carbons. Further preferred ring A¹, ring A⁴ or ring A⁵ is cyclohexylene, phenylene, phenylene in which at least one hydrogen is replaced by fluorine, or phenylene in which at least one hydrogen is replaced by alkyl having 1 to 3 carbons. Particularly preferred ring A¹, ring A⁴ or ring A⁵ is cyclohexylene, phenylene, phenylene in which at least one hydrogen is replaced by a methyl group, or phenylene in which at least one hydrogen is replaced by an ethyl group.

In formula (1γ), Z¹ and Z⁵ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine.

In formula (1γ), preferred Z¹ or Z⁵ is a single bond, —(CH₂)₂—, —CH═CH—, —C≡C—, —COO—, —OCO—, —CF₂O—, —OCF₂—, —CH₂O—, —OCH₂— or —CF═CF—. Further preferred Z¹ or Z⁵ is a single bond.

In formula (1γ), Sp¹, Sp² or Sp³ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine.

In formula (1γ) r preferred Sp¹, Sp² or Sp³ is a single bond, alkylene having 1 to 5 carbons, or alkylene having 1 to 5 carbons in which one —CH₂— is replaced by —O—. Further preferred Sp¹, Sp² or Sp³ is a single bond, alkylene having 1 to 3 carbons, or alkylene having 1 to 3 carbons in which one —CH₂— is replaced by —O—. Particularly preferred Sp¹, Sp² or Sp³ is —CH₂—, —(CH₂)₂—, —(CH₂)₃— or —O(CH₂)₂—.

In formula (1γ), P¹, P² and P³ are independently a polymerizable group represented by formula (P-1).

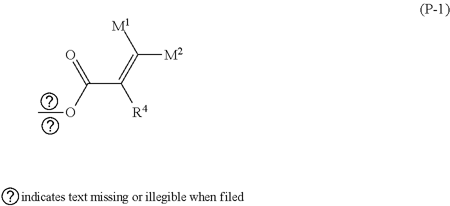

In formula (P-1), M¹ and M² are independently hydrogen, halogen, alkyl having 1 to 5 carbons, or alkyl having 1 to 5 carbons in which at least one hydrogen is replaced by halogen. Preferred M¹ or M² is hydrogen or methyl for increasing reactivity. Further preferred M¹ or M² is hydrogen.

In formula (P-1), R⁴ is a group represented by a group represented by formulas (1γa), (1γb) and (1γc). Preferred R⁴ is a group represented by formula (1γa) or (1γb). Further preferred R⁴ is a group represented by formula (1γa).

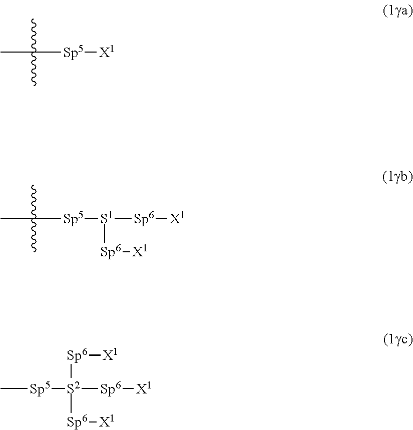

In formulas (1γa), (1γb) and (1γc), Sp⁵ and Sp⁶ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by fluorine or chlorine.

In formulas (1γa), (1γb) and (1γc), preferred Sp⁵ and Sp⁶ are a single bond, alkylene having 1 to 5 carbons, or alkylene having 1 to 5 carbons in which one —CH₂— is replaced by —O—. Further preferred Sp⁴ or Sp⁵ is a single bond, alkylene having 1 to 5 carbons, or alkylene having 1 to 5 carbons in which one —CH₂— is replaced by —O—. Particularly preferred Sp⁵ and Sp⁶ are a single bond, —CH₂—, —(CH₂)₂—, —(CH₂)₃— or —O(CH₂)₂—.

In formulas (1γa), (1γb) and (1γc), S¹ is >CH— or >N—; and S² is >C< or >Si<. Preferred S¹ is >CH— or >N—, and preferred S² is >C<. S¹ is preferred to S².

In formulas (1γa), (1γb) and (1γc), X¹ is a group represented by —OH, —NH₂, —OR³, —N(R³)₂, —COOH, —SH, —B(OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by fluorine or chlorine.

In formulas (1γa), (1γb) and (1γc), preferred X¹ is a group represented by —OH, —NH₂ or —Si(R³)₃, in which R³ is alkyl having 1 to 5 carbons or alkoxy having 1 to 4 carbons. Further preferred X¹ is —OH, —NH₂, —Si(OCH₃)₃ or —Si(OC₂H₅)₃. Particularly preferred X¹ is —OH.

In formula (1γ), a and b are independently 0, 1, 2, 3 or 4, and a sum of a and b is 1, 2, 3 or 4. A preferred combination of a and b includes (a=1, b=0), (a=0, b=1), (a=2, b=0), (a=1, b=1), (a=0, b=2), (a=3, b=0), (a=2, b=1), (a=1, b=2) or (a=0, b=3). A further preferred combination of a and b includes (a=1, b=0), (a=2, b=0), (a=1, b=1), (a=3, b=0), (a=2, b=1) or (a=1, b=2). A particularly preferred combination of a and b includes (a=1, b=0) or (a=2, b=0).

In formula (1γ) r d is 0, 1, 2, 3 or 4. Preferred d is 2 or 3, and further preferred d is 2.

In formula (1γ), c and e are independently 0, 1, 2, 3 or 4. Preferred c or e is 0.

### 9. Synthesis of Compound (1γ)

Synthesis methods of compound (1γ) will be described. Compound (1γ) can be synthesized by suitably combining methods in publicly-known synthetic organic chemistry. The synthesis methods may be applied with reference to books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

10. Example of Compound (1δ)

Compound (1δ) will be described as an example in the following items.

Item 61, A compound, represented by formula (1δ-1):

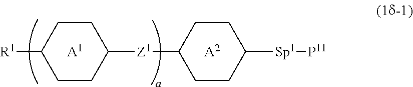

wherein, in formula (1δ-1),

R¹ is alkyl having 1 to 15 carbons, and in R¹, at least one —CH₂— may be replaced by —O— or —S—, at least one —CH₂CH₂— may be replaced by —CH═CH— or —C≡C—, and at least one hydrogen may be replaced by halogen;

ring A¹ and ring A² are independently 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;

a is 0, 1, 2, 3 or 4;

Z¹ is a single bond or alkylene having 1 to 6 carbons, and in Z¹, at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by fluorine or chlorine; and

Sp¹ is a single bond or alkylene having 1 to 10 carbons, and in Sp¹, at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by halogen, and in the groups, at least one hydrogen is replaced by a group selected from the group of groups represented by formula (1δa):

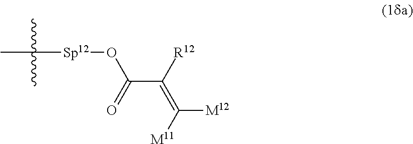

wherein, in formula (1δa),

Sp¹² is a single bond or alkylene having 1 to 10 carbons, and in Sp¹², at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by halogen;

M¹¹ and M¹² are independently hydrogen, halogen, alkyl having 1 to 5 carbons, or alkyl having 1 to 5 carbons in which at least one hydrogen is replaced by halogen; and

R¹² is alkyl having 1 to 15 carbons, and in R¹², at least one —CH₂— may be replaced by —O— or —S—, at least one —CH₂CH₂— may be replaced by —CH═CH— or —C≡C—, and at least one hydrogen may be replaced by halogen: and

in formula (1δ-1),

P¹¹ is a group selected from the group of groups represented by formulas (1δe) and (1δf):

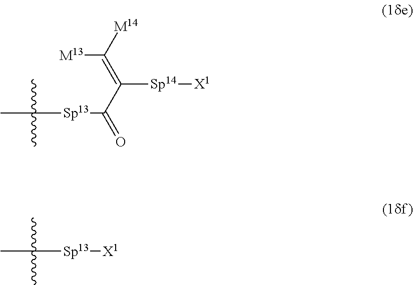

wherein, in formulas (1δe) and (1δf),

Sp¹³ is a single bond or alkylene having 1 to 10 carbons, and in Sp¹³, at least one —CH₂— may be replaced by —O—, —NH—, —CO—, —COO—, —OCO— or —OCOO—, and at least one —CH₂CH₂— may be replaced by —CH═CH— or —C≡C—, and in the groups, at least one hydrogen may be replaced by halogen;

Sp¹⁴ are independently a single bond or alkylene having 1 to 10 carbons, and in Sp¹⁴, at least one —CH₂— may be replaced by —O—, —NH—, —CO—, —COO—, —OCO— or —OCOO—, at least one —CH₂CH₂— may be replaced by —CH═CH— or —C≡C—, and at least one hydrogen may be replaced by halogen;

M¹³ and M¹⁴ are independently hydrogen, halogen, alkyl having 1 to 5 carbons, or alkyl having 1 to 5 carbons in which at least one hydrogen is replaced by halogen; and

X¹ is —OH, —NH₂, —OR¹⁵, —N(R¹⁵)₂, —COOH, —SH, —B(OH)₂ or —Si(R¹⁵)₃; and

in —OR¹⁵, —N(R¹⁵)₂ and —Si(R¹⁵)₃,

R¹⁵ is hydrogen or alkyl having 1 to 10 carbons, and in R¹⁵, at least one —CH₂— may be replaced by —O—, at least one —CH₂CH₂— may be replaced by —CH═CH—, and at least one hydrogen may be replaced by halogen.

Item 62. The compound according to item 61, represented by formulas (1δ-2) to (1δ-21):

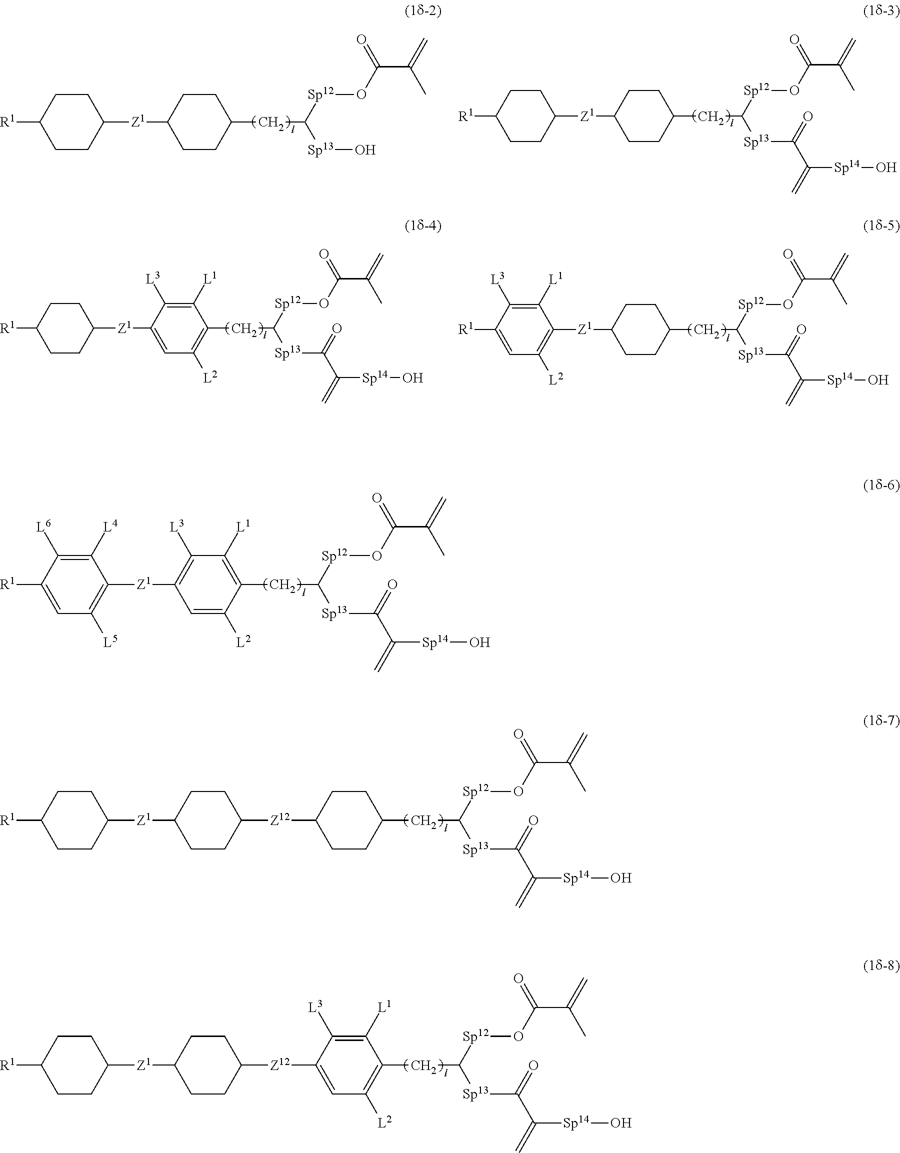

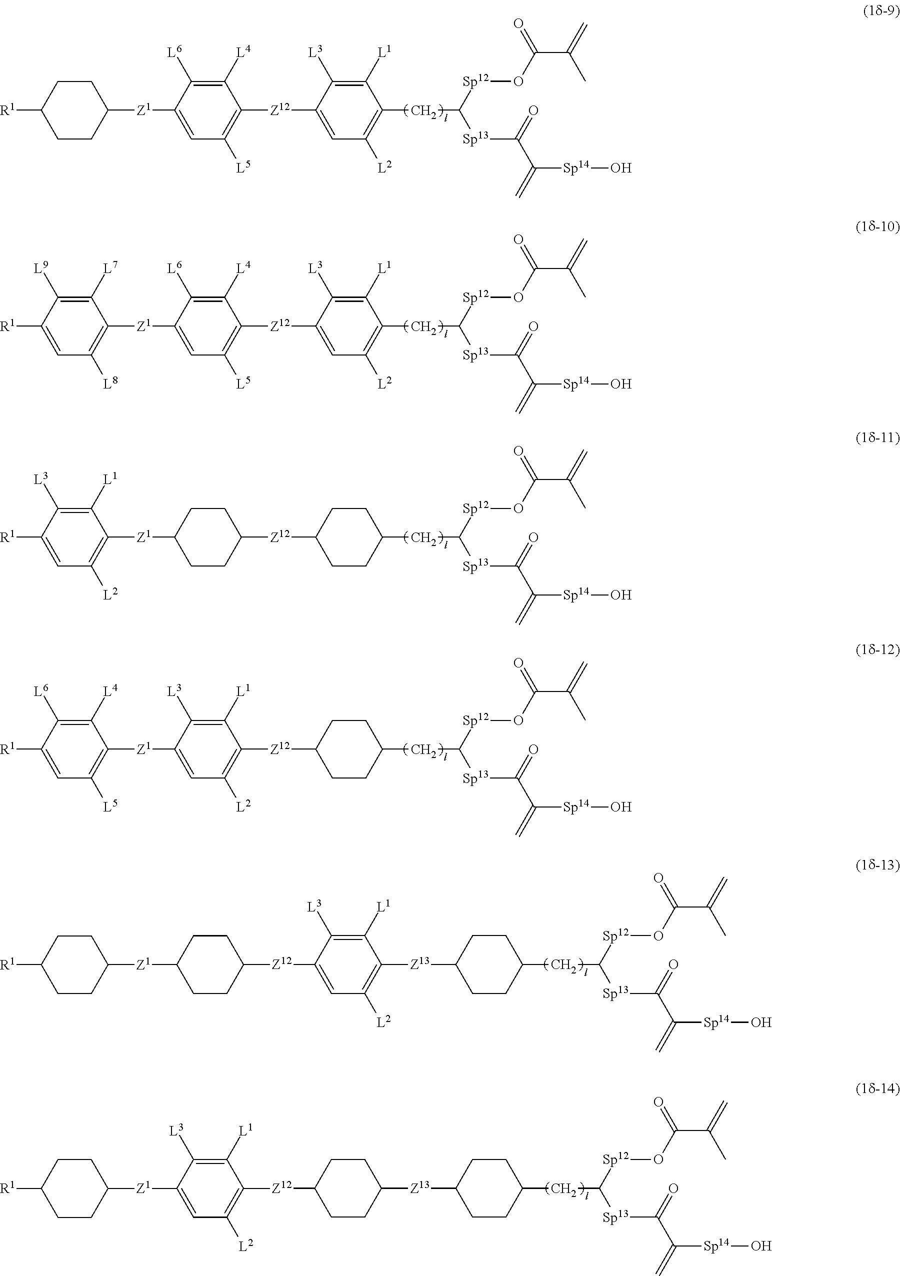

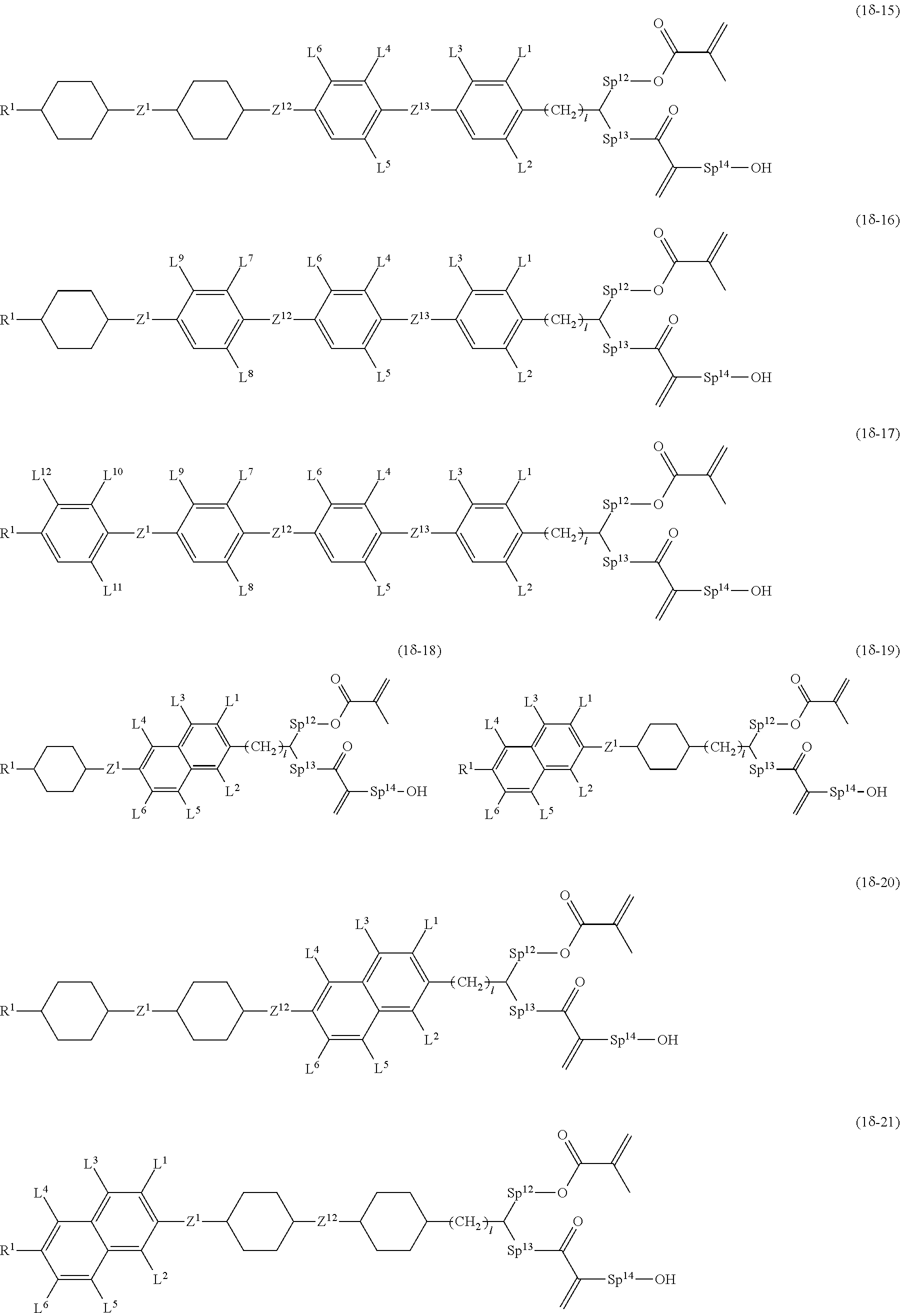

wherein, in formulas (1δ-2) to (1δ-21),

R¹ is alkyl having 1 to 10 carbons;

Z¹, Z¹² and Z¹³ are independently a single bond, —CH₂CH₂— or —(CH₂)₄—;

Sp¹², Sp¹³ and Sp¹⁴ are independently a single bond or alkylene having 1 to 5 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine, methyl or ethyl; and

l is 1, 2, 3, 4, 5 or 6.

### 11. Form of Compound (1δ)

Compound (1δ) is adsorbed onto a substrate surface by action of a polar group to control alignment of liquid crystal molecules. Compound (1δ) is required to have high compatibility with a liquid crystal compound in order to obtain a desired effect. Compound (1δ) has a six-membered ring such as 1,4-cyclohexylene and 1,4-phenylene, and has rod-like molecular structure, and moreover has a branched structure in one end of the molecular structure, and is considered that compatibility can be improved, and therefore is optimum for the purpose above. Compound (1δ) is polymerized to give a polymer. The polymer stabilizes the alignment of the liquid crystal molecules, and therefore the response time of the device is shortened and the image persistence is improved.

A preferred form of compound (1δ) will be described. In formula (1δ-1), X¹ is a polar group. Compound (1δ-1) is added to the composition, and therefore is preferably stable. When compound (1δ) is added to the composition, the compound preferably does not decrease the voltage holding ratio of the device. Compound (1δ-1) preferably has low volatility. Preferred molar mass is 130 g/mol or more. Further preferred molar mass is in the range from 150 g/mol to 700 g/mol. Preferred compound (1δ) has a polymerizable group such as acryloyloxy (—OCO—CH═CH₂) and methacryloyloxy (—OCO—(CH₃)C═CH₂).

In formula (1δ-1), X¹ is a group represented by —OH, —NH₂, —OR¹⁵, —N(R¹⁵)₂ or —Si(R¹⁵)₃, in which R¹⁵ is hydrogen or alkyl having 1 to 5 carbons, and in the alkyl, at least one —CH₂— may be replaced by —O—, and at least one —CH₂CH₂— may be replaced by —CH═CH—, and in the groups, at least one hydrogen may be replaced by fluorine. From a viewpoint of high solubility in the liquid crystal composition, X¹ is particularly preferably —OH or —NH₂. Then, —OH has high anchor force, and therefore is preferred to —O—, —CO— or —COO—. A group containing a plurality of hetero atoms (nitrogen, oxygen) is particularly preferred. A compound having such a polar group is effective even at a low concentration.

In formula (1δ-1), R¹ is alkyl having 1 to 15 carbons, and in R¹, at least one —CH₂— may be replaced by —O— or —S—, at least one —CH₂CH₂— may be replaced by —CH═CH— or —C≡C—, and at least one hydrogen may be replaced by halogen.

In formula (1δ-1), ring A¹ and ring A² are independently 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine. Preferred ring A¹ or ring A² is 1,4-cyclohexylene, 1,4-phenylene, 2-fluoro-1,4-phenylene, naphthalene-2,6-diyl or 3-ethyl-1,4-phenylene.

In formula (1δ-1), Z¹ is a single bond or alkylene having 1 to 6 carbons, and in Z¹, at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by fluorine or chlorine. Preferred Z¹ is a single bond, —CH₂CH₂—, —CH₂O—, —OCH₂—, —COO— or —OCO—. Further preferred Z¹ is a single bond.

In formula (1δ-1), Sp¹ is a single bond or alkylene having 1 to 10 carbons, and in Sp¹, at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by halogen, and in the groups, at least one hydrogen is replaced by a group selected from the group of groups represented by formula (1δa):

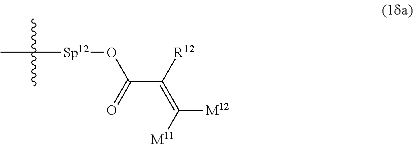

wherein, in formula (1δa), Sp¹² is a single bond or alkylene having 1 to 10 carbons, and in Sp¹², at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by halogen; and

in formula (1δa), M¹¹ and M¹² are independently hydrogen, halogen, alkyl having 1 to 5 carbons, or alkyl having 1 to 5 carbons in which at least one hydrogen is replaced by halogen; and

in formula (1δa), R¹² is alkyl having 1 to 15 carbons, and in R¹², at least one —CH₂— may be replaced by —O— or —S—, at least one —CH₂CH₂— may be replaced by —CH═CH— or —C≡C—, and at least one hydrogen may be replaced by halogen. Preferred Sp¹ is a single bond.

In formula (1δ-1), P¹¹ is a group selected from the group of groups represented by formulas (1δe) and (1δf):

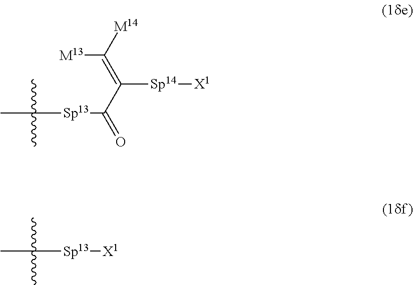

wherein, in formulas (1δe) and (1δf),

Sp¹³ is a single bond or alkylene having 1 to 10 carbons, and in Sp¹³, at least one —CH₂— may be replaced by —O—, —NH—, —CO—, —COO—, —OCO— or —OCOO—, and at least one —CH₂CH₂— may be replaced by —CH═CH— or —C≡C—, and in the groups, at least one hydrogen may be replaced by halogen;

Sp¹⁴ are independently a single bond or alkylene having 1 to 10 carbons, and in Sp¹⁴, at least one —CH₂— may be replaced by —O—, —NH—, —CO—, —COO—, —OCO— or —OCOO—, at least one —CH₂CH₂— may be replaced by —CH═CH— or —C≡C—, and at least one hydrogen may be replaced by halogen;

M¹³ and M¹⁴ are independently hydrogen, halogen, alkyl having 1 to 5 carbons, or alkyl having 1 to 5 carbons in which at least one hydrogen is replaced by halogen; and

X¹ is —OH, —NH₂, —OR¹⁵, —N(R¹⁵)₂, —COOH, —SH, —B(OH)₂ or —Si(R¹⁵)₃; and

in —OR¹⁵, —N(R¹⁵)₂ and —Si(R¹⁵)₃,

R¹⁵ is hydrogen or alkyl having 1 to 10 carbons, and in R¹⁵, at least one —CH₂— may be replaced by —O—, at least one —CH₂CH₂— may be replaced by —CH═CH—, and at least one hydrogen may be replaced by halogen.

In formula (1δ-1), a is 0, 1, 2, 3 or 4. Preferred a is 0, 1 or 2.

In formulas (1δ-2) to (1δ-21),

R¹ is alkyl having 1 to 10 carbons;

Z¹, Z¹² and Z¹³ are independently a single bond, —CH₂CH₂— or —(CH₂)₄—; Sp¹², Sp¹³ and Sp¹⁴ are independently a single bond or alkylene having 1 to 5 carbons, and in the alkylene, at least one —CH₂— may be replaced by —O—; and

L¹, L², L³, L⁴, L⁵, L⁶, L⁷, L⁸, L⁹, L¹⁰, L¹¹ and L¹² are independently hydrogen, fluorine, methyl or ethyl.

Preferred compound (1δ) includes compound (1δ-2) to compound (1δ-21) described in item 62. In the compounds, at least one of the alignable monomers preferably includes compound (1δ-2), compound (1δ-3), compound (1δ-4), compound (1δ-11), compound (1δ-19) or compound (1δ-21). At least two of the alignable monomers preferably include a combination of compound (1δ-2) and compound (1δ-3) or a combination of compound (1δ-3) and compound (1δ-4).

### 12. Synthesis of Compound (1δ)

A method for synthesizing compound (1δ) is described in a section of Examples.

### 13. Example of Compound (1ε)

Compound (1ε) will be described as an example in the following items.

Item 81. A compound, represented by formula (1ε):

R¹-MES-Sp¹-P¹ (1ε)

wherein, in formula (1ε),

R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;

MES is a mesogen group having at least one ring; and

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen, and in the groups, at least one hydrogen is replaced by a group selected from the group of groups represented by formulas (1εa), (1εb), (1εc) and (1εd):

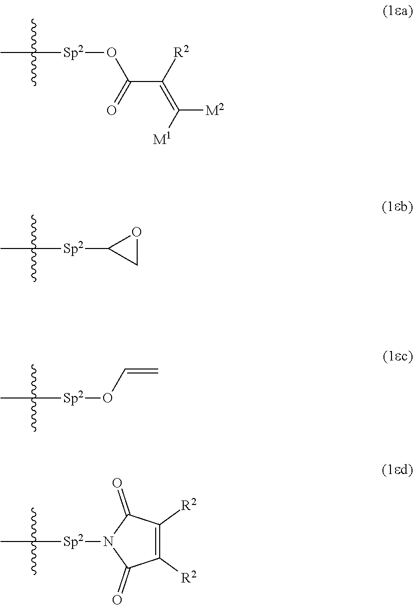

wherein, in formulas (1εa), (1εb), (1εc) and (1εd),

Sp² is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, halogen, alkyl having 1 to 5 carbons, or alkyl having 1 to 5 carbons in which at least one hydrogen is replaced by halogen; and

R² is hydrogen or alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen; and

in formula (1ε),

P¹ is a group selected from the group of groups represented by formulas (1εe) and (1εf):

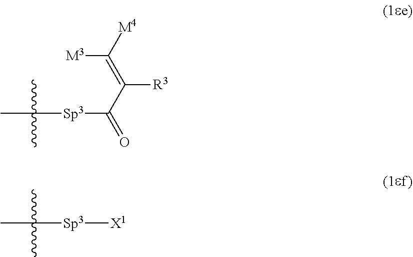

wherein, in formulas (1εe) and (1εf),

Sp³ is a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

M³ and M⁴ are independently hydrogen, halogen, alkyl having 1 to 5 carbons, or alkyl having 1 to 5 carbons in which at least one hydrogen is replaced by halogen; X¹ is —OH, —NH₂, —OR⁵, —N(R⁵)₂, —COOH, —SH, —B(OH)₂ or —Si(R⁵)₃; and

R³ is a group selected from the group of groups represented by formulas (1εg), (1εh) and (1εi):

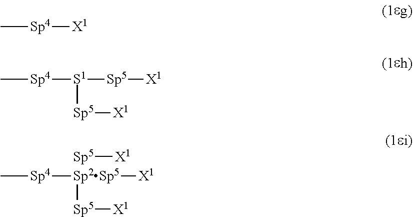

wherein, in formulas (1εg), (1εh) and (1εi),

Sp⁴ and Sp⁵ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

S¹ is >CH— or >N—;

S² is >C< or >Si<; and

X¹ is —OH, —NH₂, —OR⁵, —N(R⁵)₂, —COOH, —SH, —B(OH)₂ or —Si(R⁵)₃; and

in —OR⁵, —N(R⁵)₂ and —N(R⁵)₂,

R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen.

Item 82. The compound according to item 81, represented by formula (1ε-1):

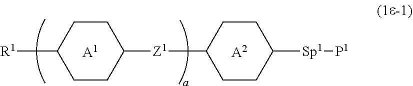

wherein, in formula (1ε-1),

R¹ is alkyl having 1 to 12 carbons, and in the alkyl, at least one —CH₂— may be replaced by —O—, and at least one —(CH₂)₂— may be replaced by —CH═CH— or —C≡C—, and in the groups, at least one hydrogen may be replaced by fluorine;

ring A¹ and ring A² are independently 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;

a is 0, 1, 2, 3 or 4;

Z¹ is a single bond or alkylene having 1 to 6 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine or chlorine; and

Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine or chlorine, and in the groups, at least one hydrogen is replaced by a polymerizable group represented by formula (1εa):

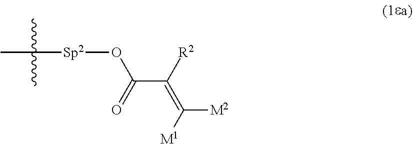

wherein, in formula (1εa),

Sp² is a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, fluorine, chlorine, alkyl having 1 to 5 carbons, or alkyl having 1 to 5 carbons in which at least one hydrogen is replaced by fluorine or chlorine; and

R² is hydrogen or alkylene having 1 to 15 carbons, and in the alkylene, at least one —CH₂— may be replaced by —O— or —S—, and at least one —(CH₂)₂— may be replaced by —CH═CH— or —C≡C—, and in the groups, at least one hydrogen may be replaced by fluorine or chlorine; and

in formula (1ε-1),

P¹ is a group selected from the group of groups represented by formulas (1εe) and (1εf):

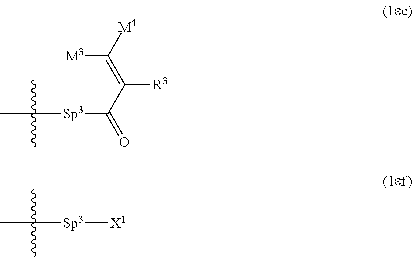

wherein, in formulas (1εe) and (1εf),

Sp³ is a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by fluorine or chlorine;

M³ and M⁴ are independently hydrogen, fluorine, chlorine, alkyl having 1 to 5 carbons, or alkyl having 1 to 5 carbons in which at least one hydrogen is replaced by fluorine or chlorine;

X¹ is —OH, —NH₂, —OR⁵, —N(R⁵)₂, —COOH, —SH or —Si(R⁵)₃; and

R³ is a group selected from the group of groups represented by formulas (1εg) and (1εh):

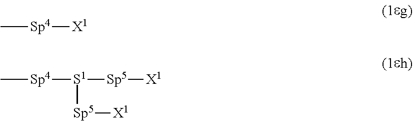

wherein, in formulas (1εg) and (1εh),

Sp⁴ and Sp⁵ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by fluorine or chlorine;

S¹ is >CH— or >N—; and

X¹ is —OH, —NH₂, —OR⁵, —N(R⁵)₂, —COOH, —SH or —Si(R⁵)₃; and

in —OR⁵, —N(R⁵)₂ and —Si(R⁵)₃,

R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by fluorine or chlorine.

Item 83. The compound according to item 82, wherein, in formula (1ε-1),

Z¹ is a single bond, —(CH₂)₂—, —(CH₂)₄—, —CH═CH—, —C≡C—, —COO—, —OCO—, —CF₂O—, —OCF₂—, —CH₂O—, —OCH₂— or —CF═CF—; and

in formula (1εa),

M¹ and M² are independently hydrogen, fluorine, alkyl having 1 to 5 carbons, or alkyl having 1 to 5 carbons in which at least one hydrogen is replaced by fluorine; and

in formula (1εe),

M³ and M⁴ are independently hydrogen, fluorine, alkyl having 1 to 5 carbons, or alkyl having 1 to 5 carbons in which at least one hydrogen is replaced by fluorine; and

R³ is a group represented by formula (1εg).

Item 84. The compound according to item 82 or 83, wherein, in formula (1ε-1),

ring A¹ and ring A² are independently 1,4-cyclohexylene, 1,4-cyclohexenylene, 1,4-phenylene, naphthalene-2,6-diyl, decahydronaphthalene-2,6-diyl, tetrahydropyran-2,5-diyl, 1,3-dioxane-2,5-diyl, fluorene-2,7-diyl, phenanthrene-2,7-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 10 carbons, alkenyl having 2 to 10 carbons, alkoxy having 1 to 9 carbons or alkenyloxy having 2 to 9 carbons, and in the groups, at least one hydrogen may be replaced by fluorine; and

Sp¹ is a single bond or alkylene having 1 to 8 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine, and in the groups, at least one hydrogen is replaced by a group represented by formula (1εa):

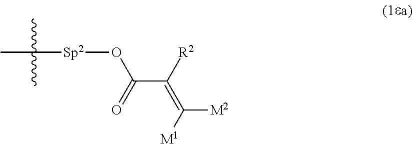

wherein, in formula (1εa),

Sp² is a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, fluorine, methyl, ethyl or trifluoromethyl; and

R² is hydrogen or alkylene having 1 to 8 carbons, and in the alkylene, at least one —CH₂— may be replaced by —O—, and at least one —(CH₂)₂— may be replaced by —CH═CH— or —C≡C—, and in the groups, at least one hydrogen may be replaced by fluorine; and

in formula (1ε-1),

P¹ is a group selected from the group of groups represented by formulas (1εe) and (1εf):

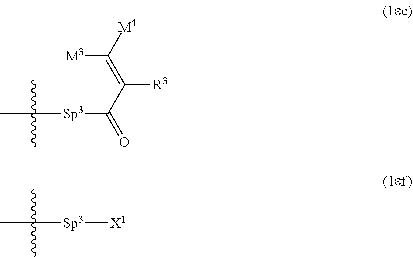

wherein, in formulas (1εe) and (1εf),

Sp³ is a single bond or alkylene having 1 to 5 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine;

M³ and M⁴ are independently hydrogen, fluorine, methyl, ethyl or trifluoromethyl;

X¹ is —OH, —NH₂ or —N(R⁵)₂; and

R³ is a group represented by formula (1εg):

-Sp⁴-X¹ (1εg)

wherein, in formulas (1εg),

Sp⁴ is a single bond or alkylene having 1 to 5 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine; and

X¹ is —OH, —NH₂ or —N(R⁵)₂; and

in —N(R⁵)₂,

R⁵ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine.

Item 85. The compound according to item 81, represented by formula (1ε-2) or (1ε-3):

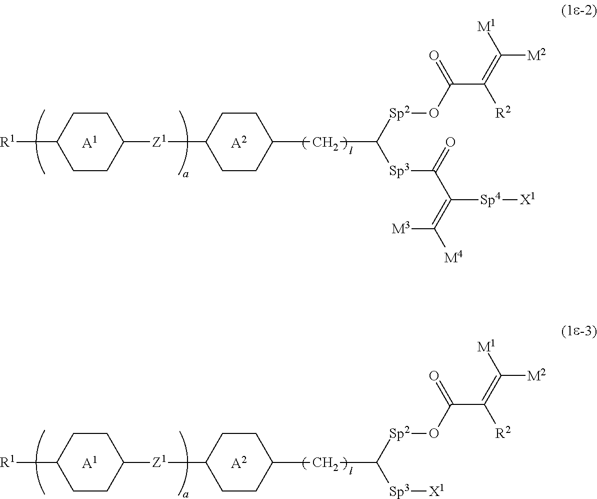

wherein, in formulas (1ε-2) and (1ε-3),

R¹ is alkyl having 1 to 12 carbons, and in the alkyl, at least one —CH₂— may be replaced by —O—, and at least one —(CH₂)₂— may be replaced by —CH═CH— or —C≡C—, and in the groups, at least one hydrogen may be replaced by fluorine;

ring A¹ and ring A² are independently 1,4-cyclohexylene, 1,4-cyclohexenylene, 1,4-phenylene, naphthalene-2,6-diyl, tetrahydropyran-2,5-diyl, 1,3-dioxane-2,5-diyl, fluorene-2,7-diyl, phenanthrene-2,7-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, alkyl having 1 to 8 carbons, alkenyl having 2 to 8 carbons, alkoxy having 1 to 7 carbons or alkenyloxy having 2 to 7 carbons, and in the groups, at least one hydrogen may be replaced by fluorine;

a is 0, 1, 2, 3 or 4;

l is 1, 2, 3, 4, 5 or 6, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine;

Sp² is a single bond or alkylene having 1 to 5 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by fluorine;

M¹ and M² are independently hydrogen, fluorine, methyl, ethyl or trifluoromethyl;

R² is hydrogen or alkyl having 1 to 5 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by fluorine;

Sp³ is a single bond or alkylene having 1 to 5 carbons, and in the alkylene, at least one —CH₂— may be replaced by —O—, —CO— or —COO—, and at least one —(CH₂)₂— may be replaced by —CH═CH— or —C≡C—, and in the groups, at least one hydrogen may be replaced by fluorine;

M³ and M⁴ are independently hydrogen, fluorine, methyl, ethyl or trifluoromethyl;

Sp⁴ is a single bond or alkylene having 1 to 5 carbons, and in the alkylene, at least one —CH₂— may be replaced by —O—, —CO— or —COO—, and at least one —(CH₂)₂— may be replaced by —CH═CH— or —C≡C—, and in the groups, at least one hydrogen may be replaced by fluorine; and

X¹ is —OH or —N(R⁵)₂; and

in —N(R⁵)₂,

R⁵ is hydrogen or alkyl having 1 to 5 carbons, and in the alkyl, at least one —CH₂— may be replaced by —O—, and at least one —(CH₂)₂— may be replaced by —CH═CH—, and in the groups, at least one hydrogen may be replaced by fluorine.

Item 86. The compound according to item 85, wherein, in formulas (1ε-2) and (1ε-3),

R¹ is alkyl having 1 to 10 carbons, alkenyl having 2 to 10 carbons or alkoxy having 1 to 9 carbons, and in the groups, at least one hydrogen may be replaced by fluorine;

ring A¹ and ring A² are independently 1,4-cyclohexylene, 1,4-phenylene, naphthalene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons;

a is 0, 1, 2, 3 or 4;

Z¹ is a single bond, —(CH₂)₂—, —(CH₂)₄—, —CH═CH—, —CF₂O—, —OCF₂—, —CH₂O— or —OCH₂—;

Sp² is a single bond or alkylene having 1 to 5 carbons, and in the alkylene, at least one —CH₂— may be replaced by —O—, and at least one —(CH₂)₂— may be replaced by —CH═CH—;

M¹ and M² are independently hydrogen, methyl or ethyl;

R² is hydrogen or alkyl having 1 to 5 carbons, and in the alkyl, at least one —CH₂— may be alternatively replaced by —O—, and at least one —(CH₂)₂— may be alternatively replaced by —CH═CH—;

Sp³ is a single bond or alkylene having 1 to 5 carbons, and in the alkylene, at least one —CH₂— may be replaced by —O—, and at least one —(CH₂)₂— may be replaced by —CH═CH—;

M³ and M⁴ are independently hydrogen, fluorine, methyl or ethyl;

Sp⁴ is a single bond or alkylene having 1 to 5 carbons, and in the alkylene, at least one —CH₂— may be replaced by —O—, and at least one —(CH₂)₂— may be replaced by —CH═CH—; and

X¹ is —OH or —N(R⁵)₂; and

in —N(R⁵)₂,

R⁵ is hydrogen or alkyl having 1 to 3 carbons, and in the alkyl, at least one —CH₂— may be replaced by —O—.

Item 87. The compound according to item 85, wherein, in formulas (1ε-2) and (1ε-3),

R¹ is alkyl having 1 to 10 carbons, alkenyl having 2 to 10 carbons or alkoxy having 1 to 9 carbons;

ring A¹ and ring A² are independently 1,4-cyclohexylene, 1,4-phenylene or naphthalene-2,6-diyl, and in the rings, at least one hydrogen may be replaced by fluorine or alkyl having 1 to 5 carbons;

a is 0, 1, 2 or 3;

Z¹ is a single bond, —(CH₂)₂— or —(CH₂)₄—;

Sp² is a single bond or alkylene having 1 to 3 carbons, and in the alkylene, at least one —CH₂— may be replaced by —O—;

M¹ and M² are independently hydrogen or methyl;

R² is hydrogen or alkyl having 1 to 5 carbons, and in the alkyl, at least one —CH₂— may be alternatively replaced by —O—;

Sp³ is a single bond or alkylene having 1 to 3 carbons, and in the alkylene, at least one —CH₂— may be replaced by —O—;

M³ and M⁴ are independently hydrogen or methyl;

Sp⁴ is a single bond or alkylene having 1 to 3 carbons, and in the alkylene, at least one —CH₂— may be replaced by —O—; and

X¹ is —OH.

Item 88. The compound according to item 81, represented by any one of formulas (1ε-4) to (1ε-41):

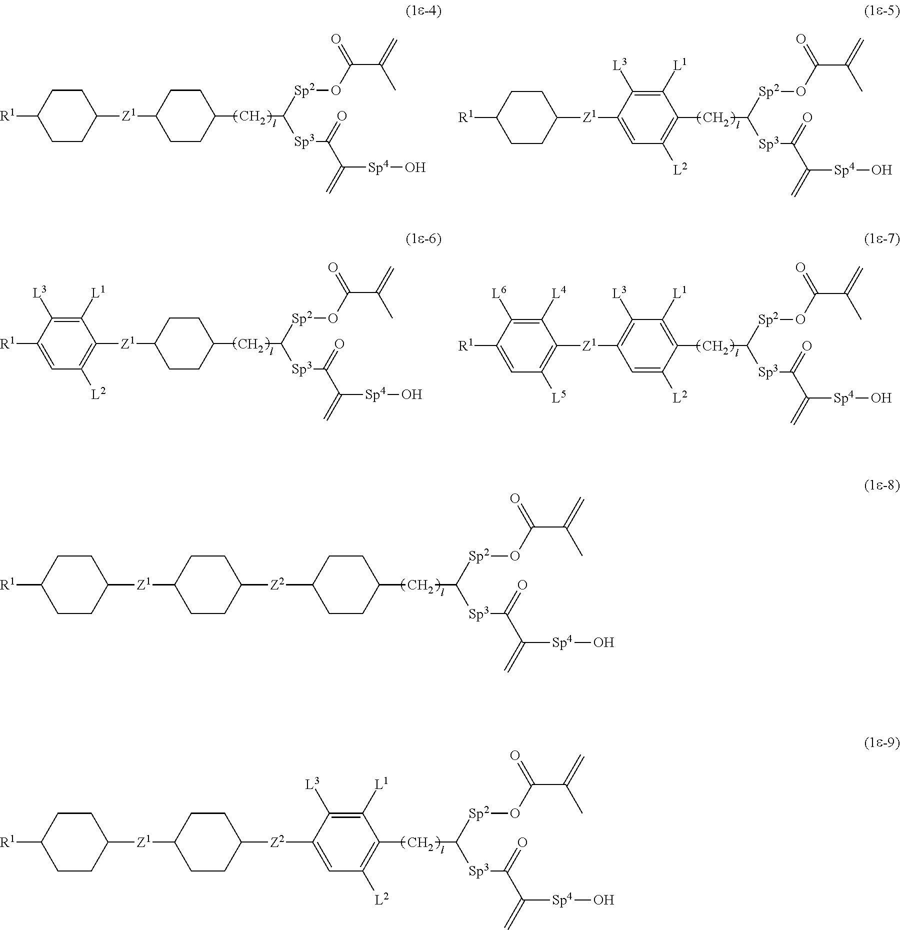

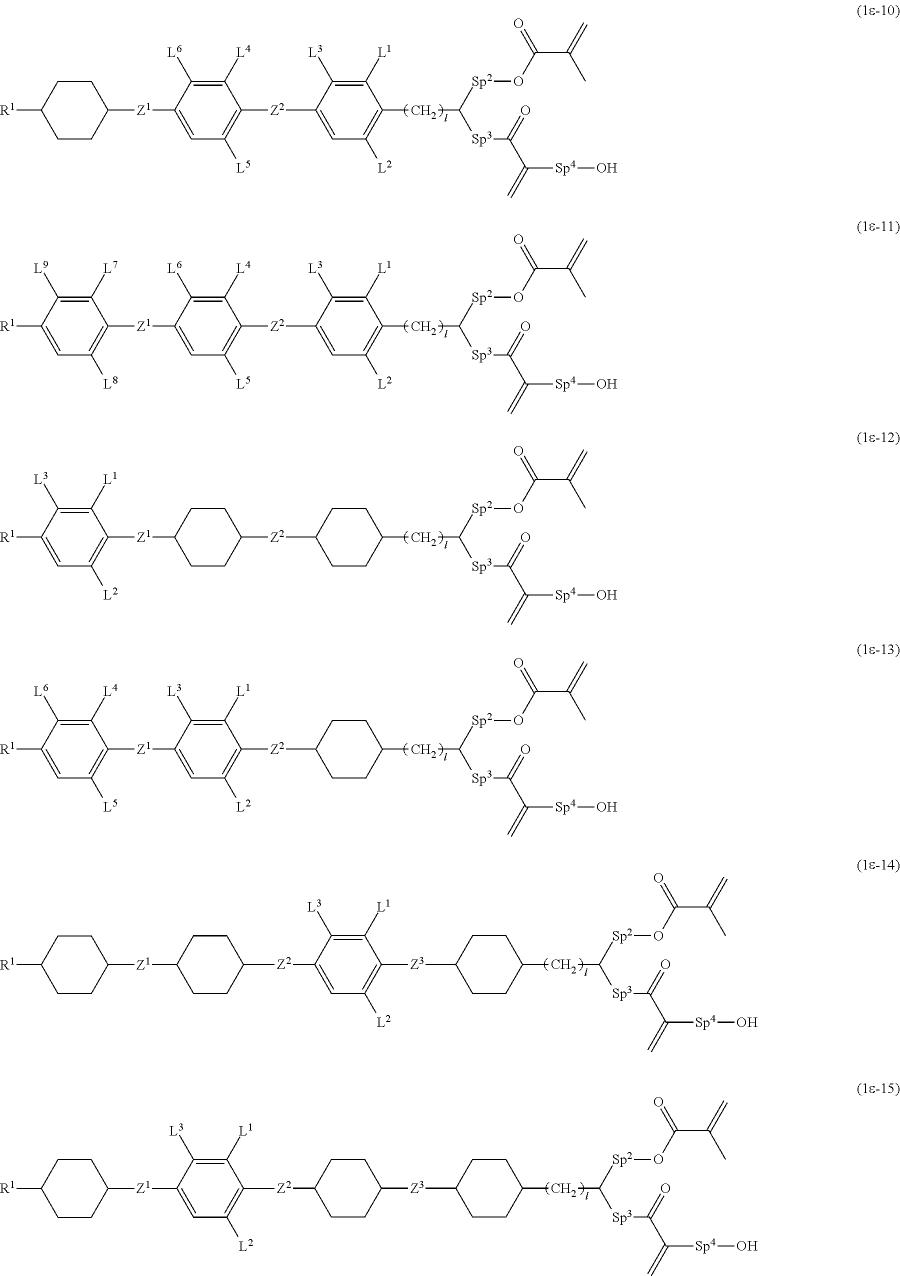

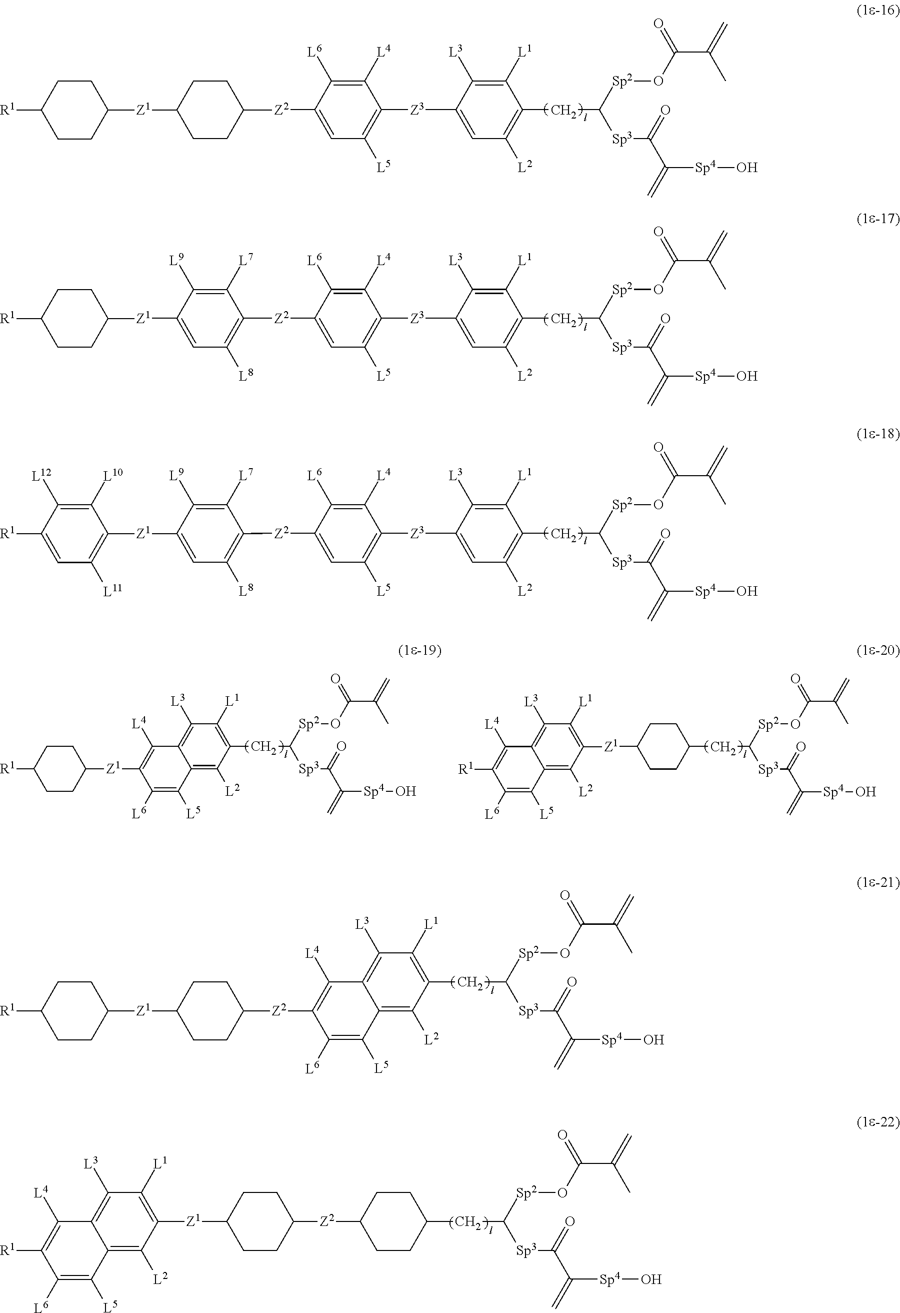

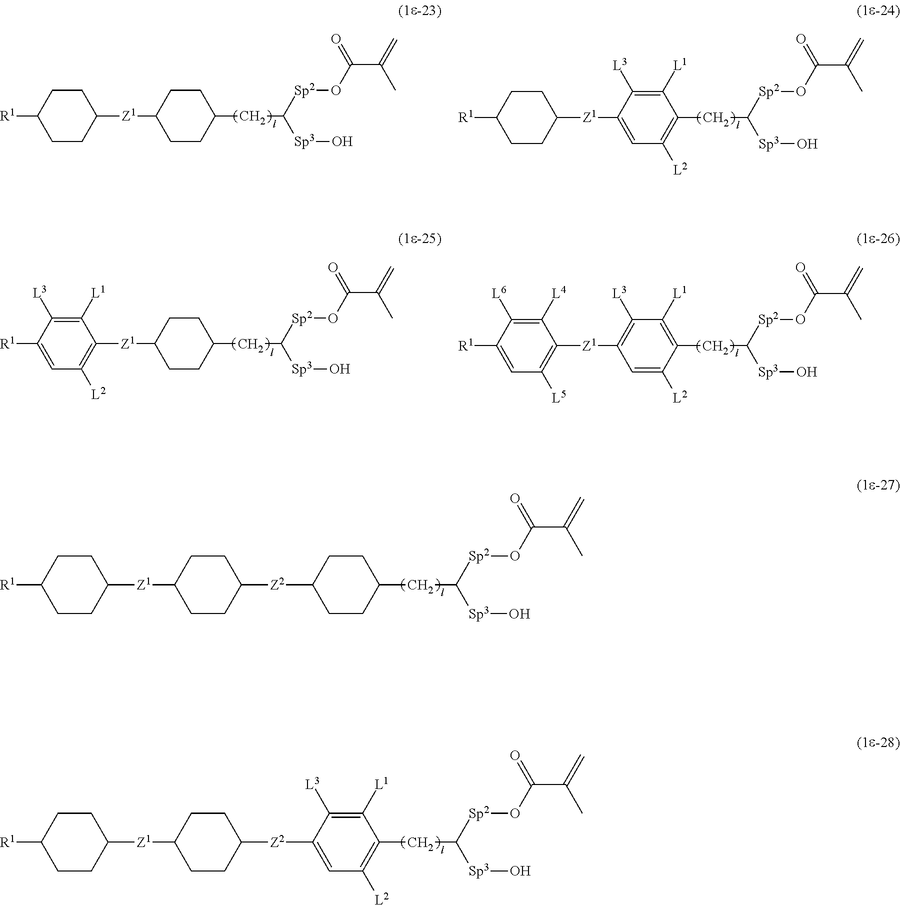

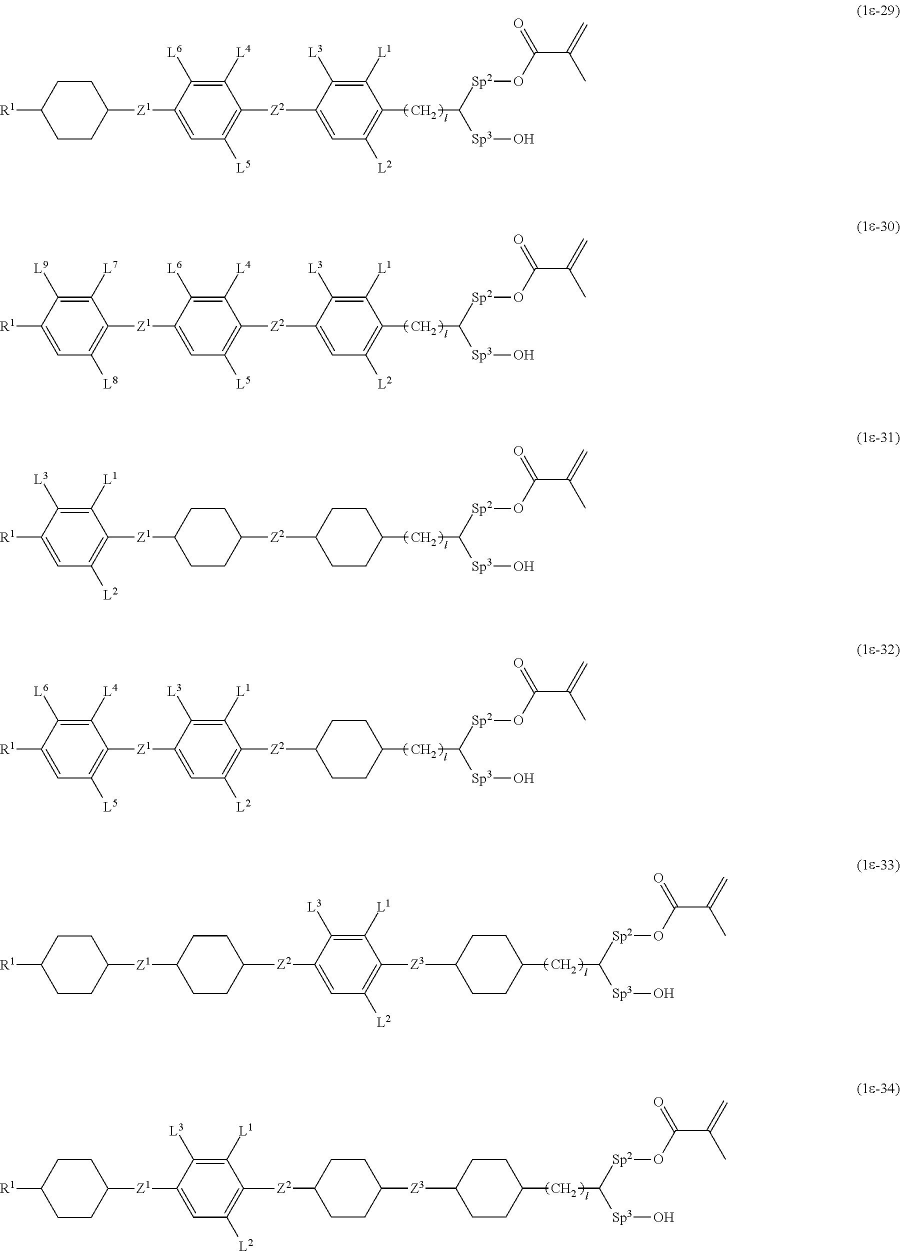

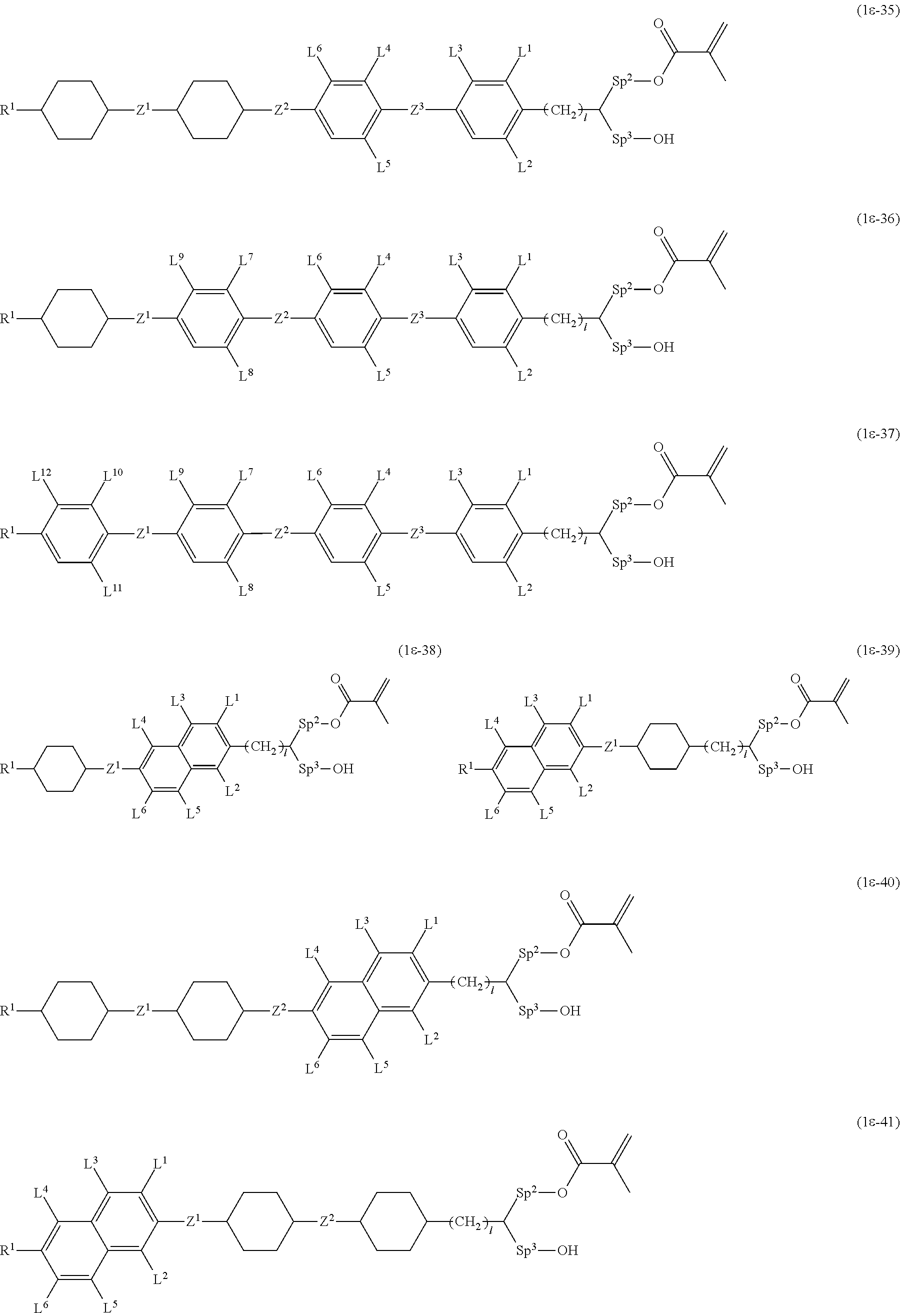

wherein, in formulas (1ε-4) to (1ε-41),

R¹ is alkyl having 1 to 10 carbons;

Z¹, Z² and Z³ are independently a single bond, —(CH₂)₂— or —(CH₂)₄—;

Sp², Sp³ and Sp⁴ are independently alkylene having 1 to 5 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine, methyl or ethyl; and

l is 1, 2, 3, 4, 5 or 6.

Item 89. The compound according to item 81, represented by any one of formulas (1ε-42) to (1ε-60):

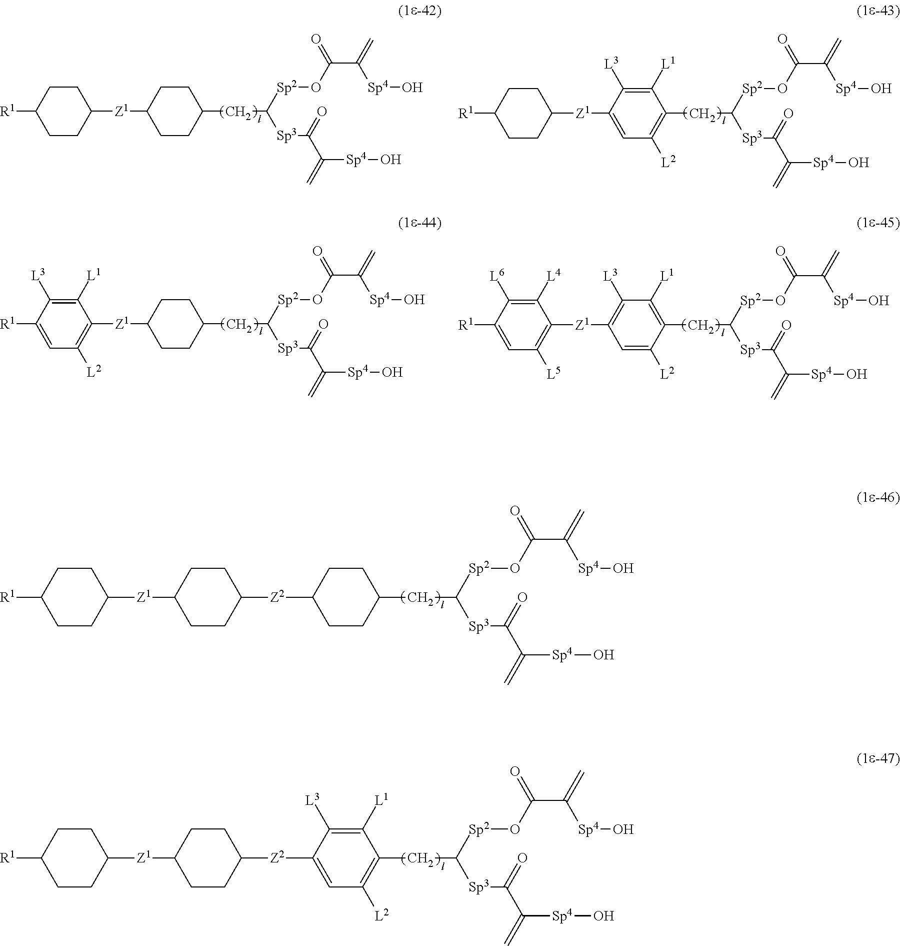

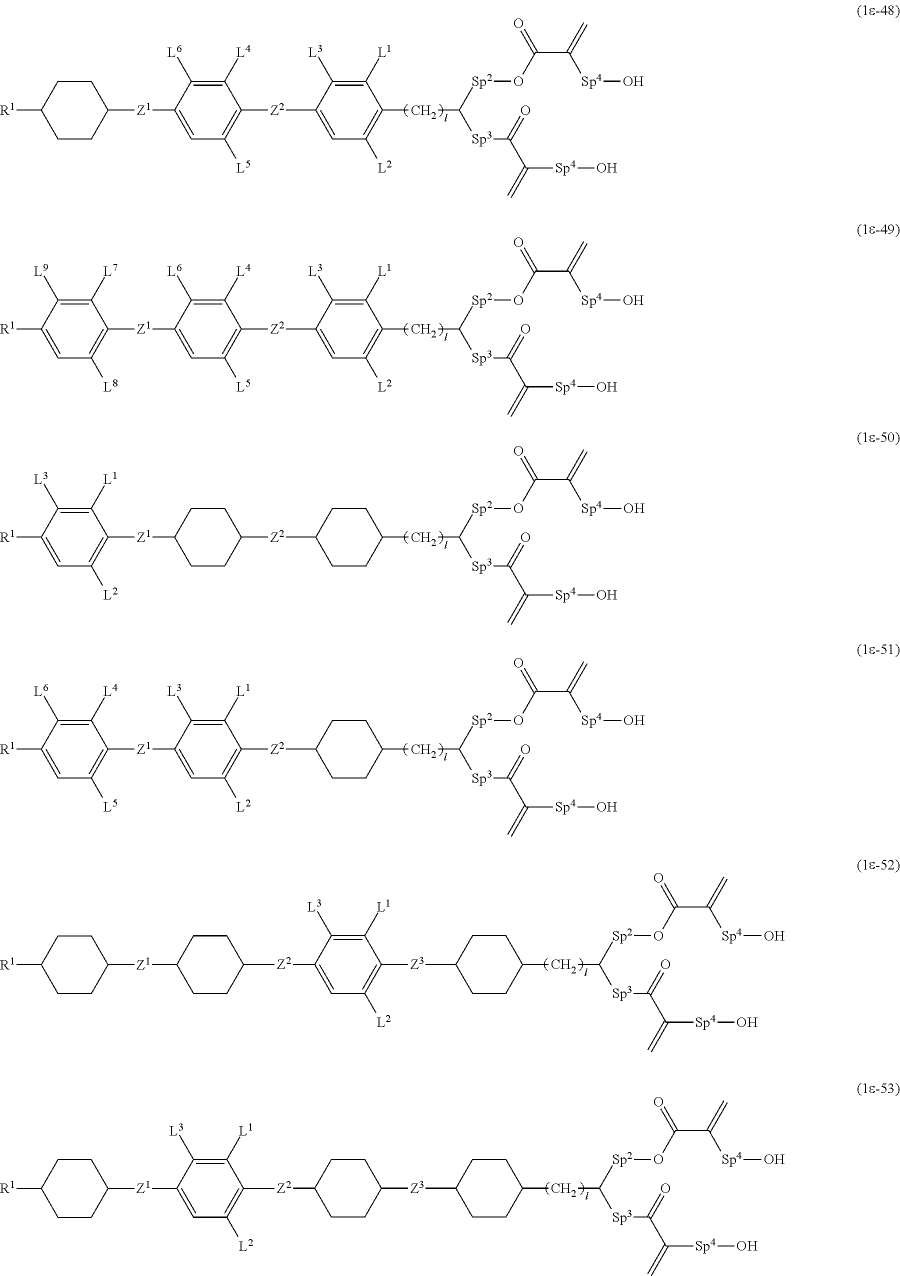

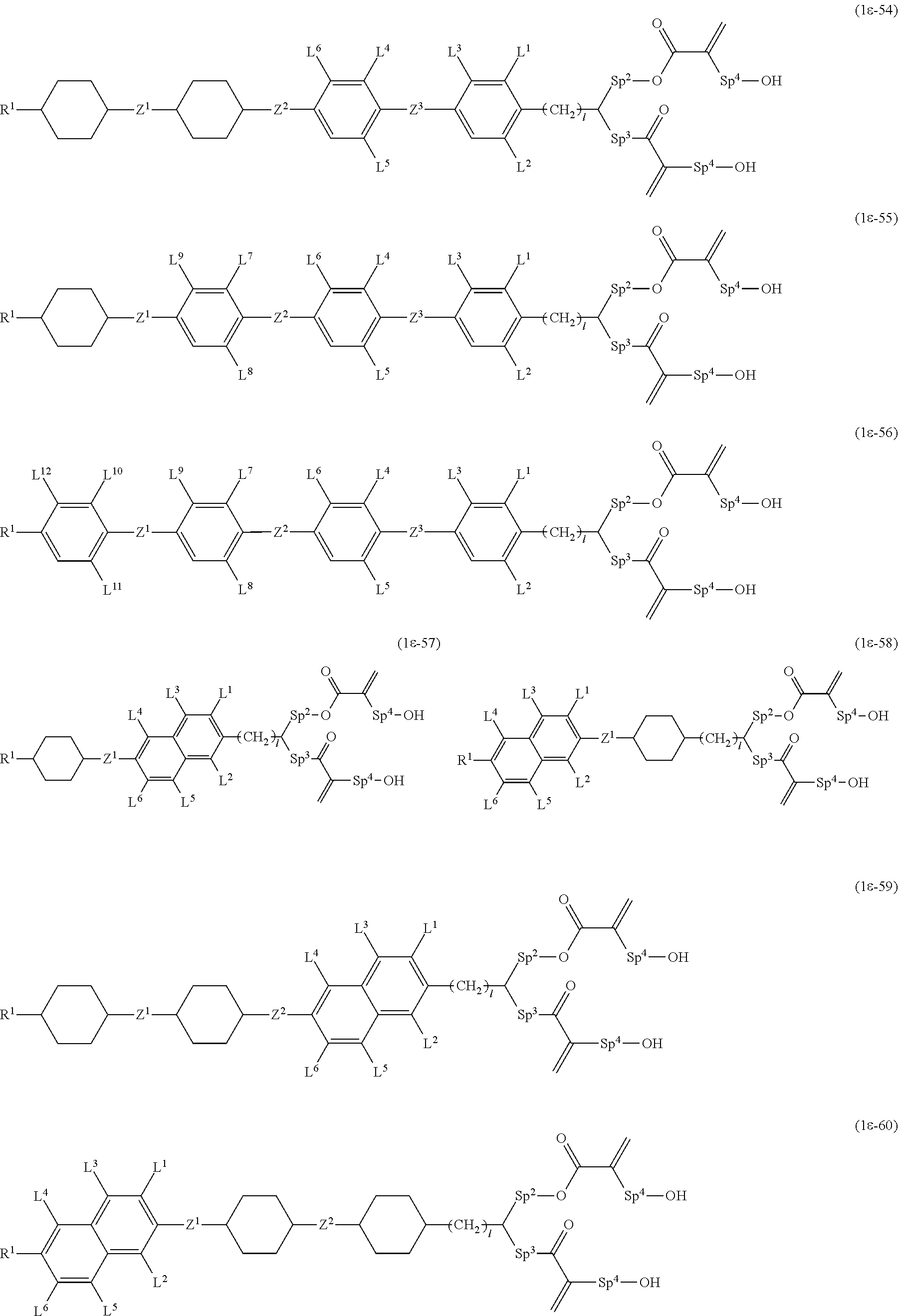

wherein, in formulas (1ε-42) to (1ε-60),

R¹ is alkyl having 1 to 10 carbons;

Z¹, Z² and Z³ are independently a single bond, —(CH₂)₂— or —(CH₂)₄—;

Sp², Sp³ and Sp⁴ are independently alkylene having 1 to 5 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine, methyl or ethyl; and

l is 1, 2, 3, 4, 5 or 6.

Item 90. The compound according to item 81, represented by any one of formulas (1ε-61) to (1ε-98):

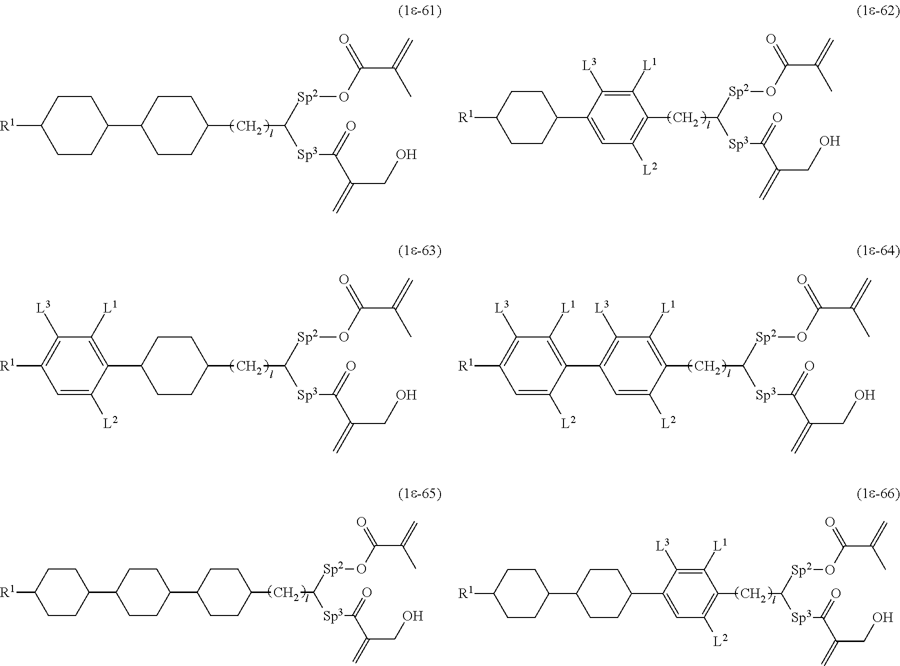

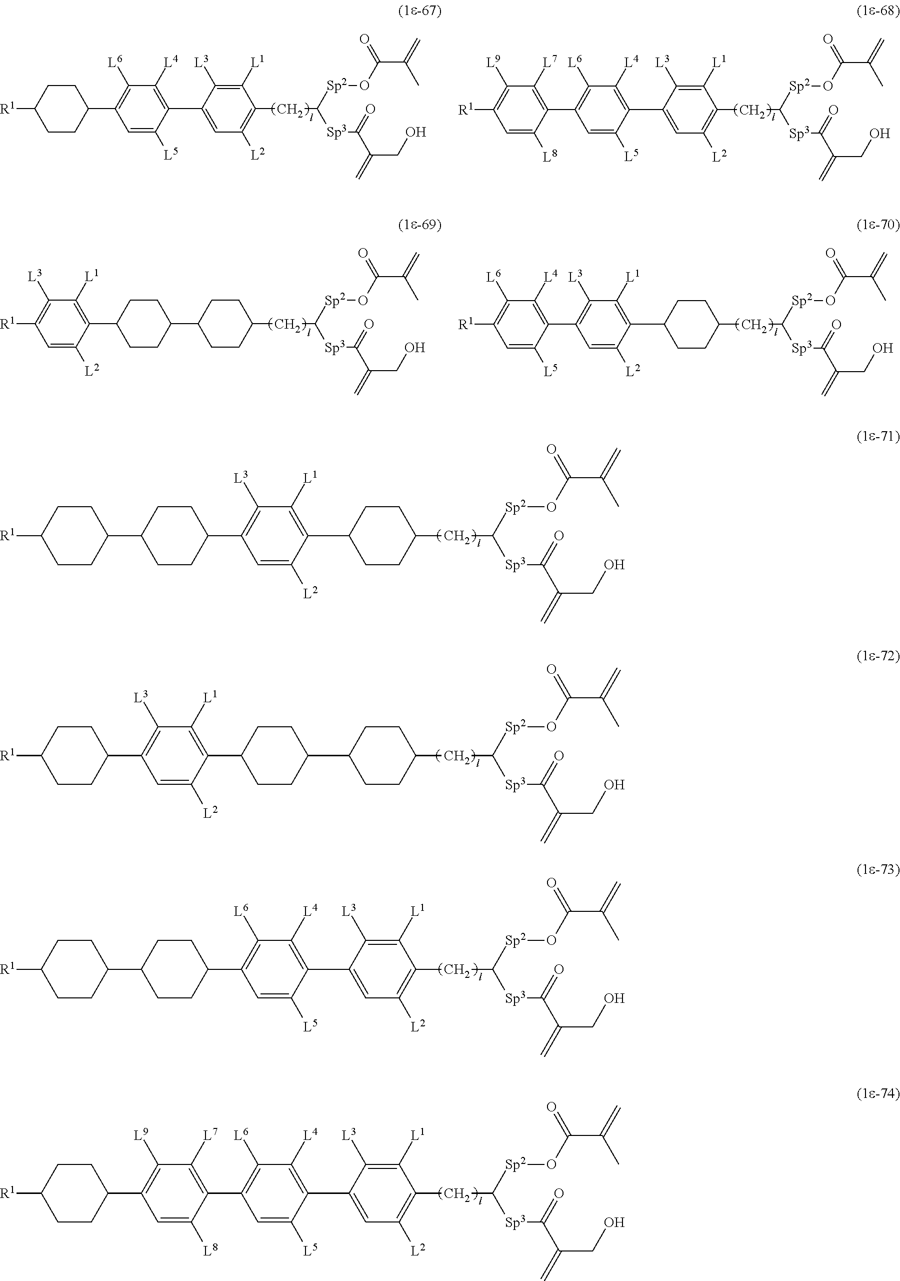

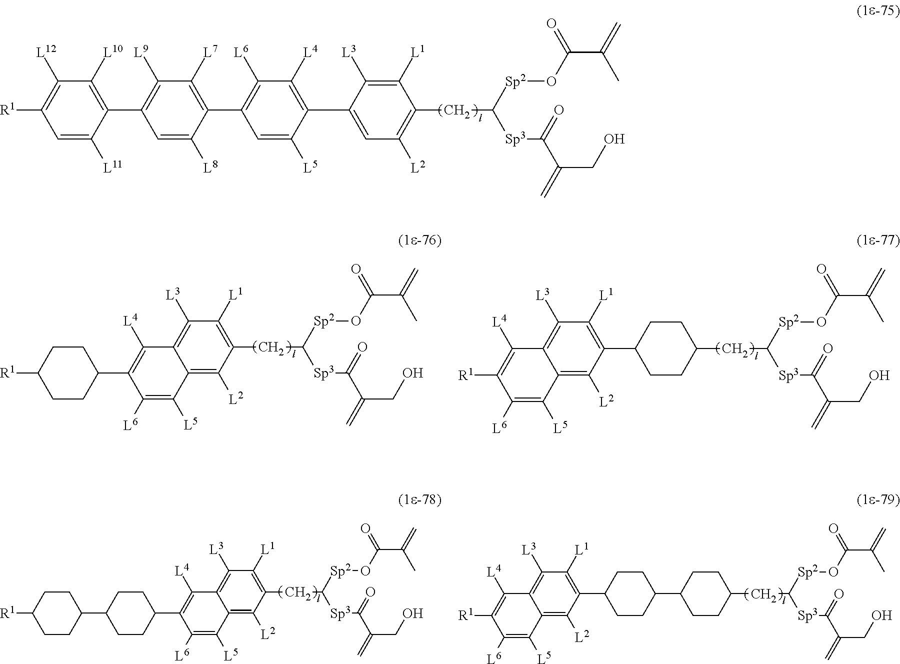

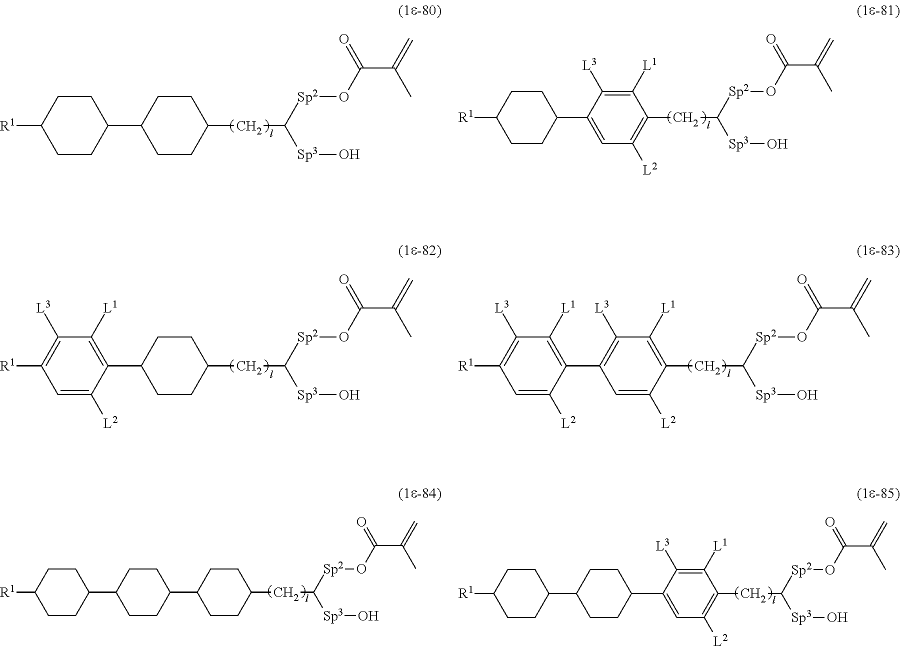

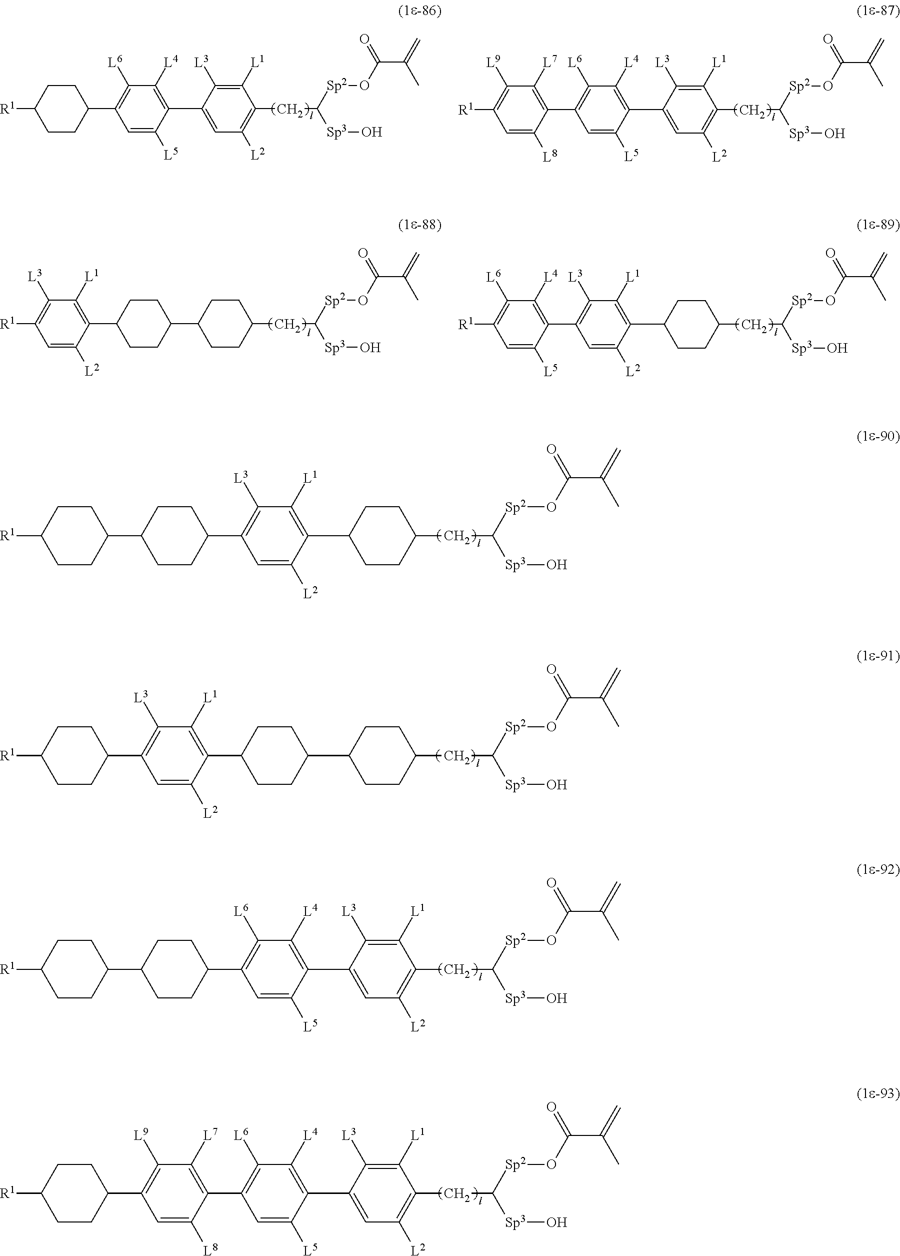

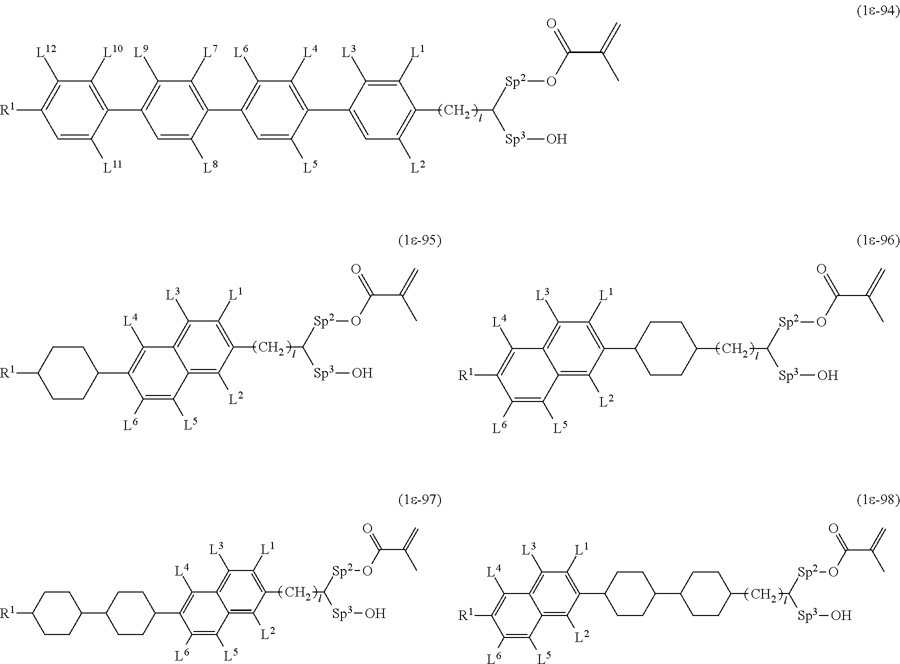

wherein, in formulas (1ε-61) to (1ε-98),

R¹ is alkyl having 1 to 10 carbons;

Sp² and Sp³ are independently alkylene having 1 to 3 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine or methyl; and

l is 1, 2, 3 or 4, and in the alkylene, at least one —CH₂— may be replaced by —O—.

Item 91. The compound according to item 81, represented by any one of formulas (1ε-99) to (1ε-117):

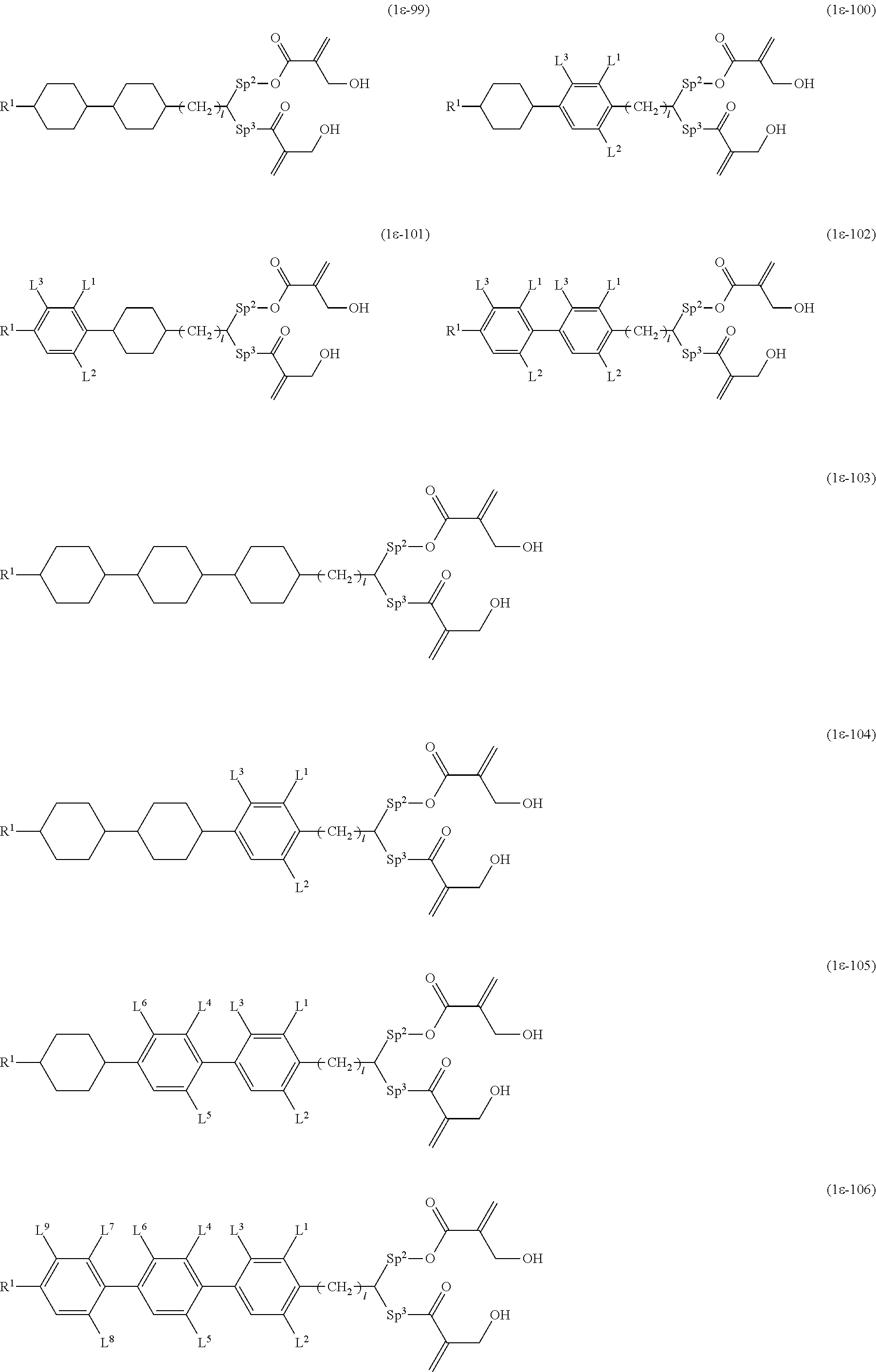

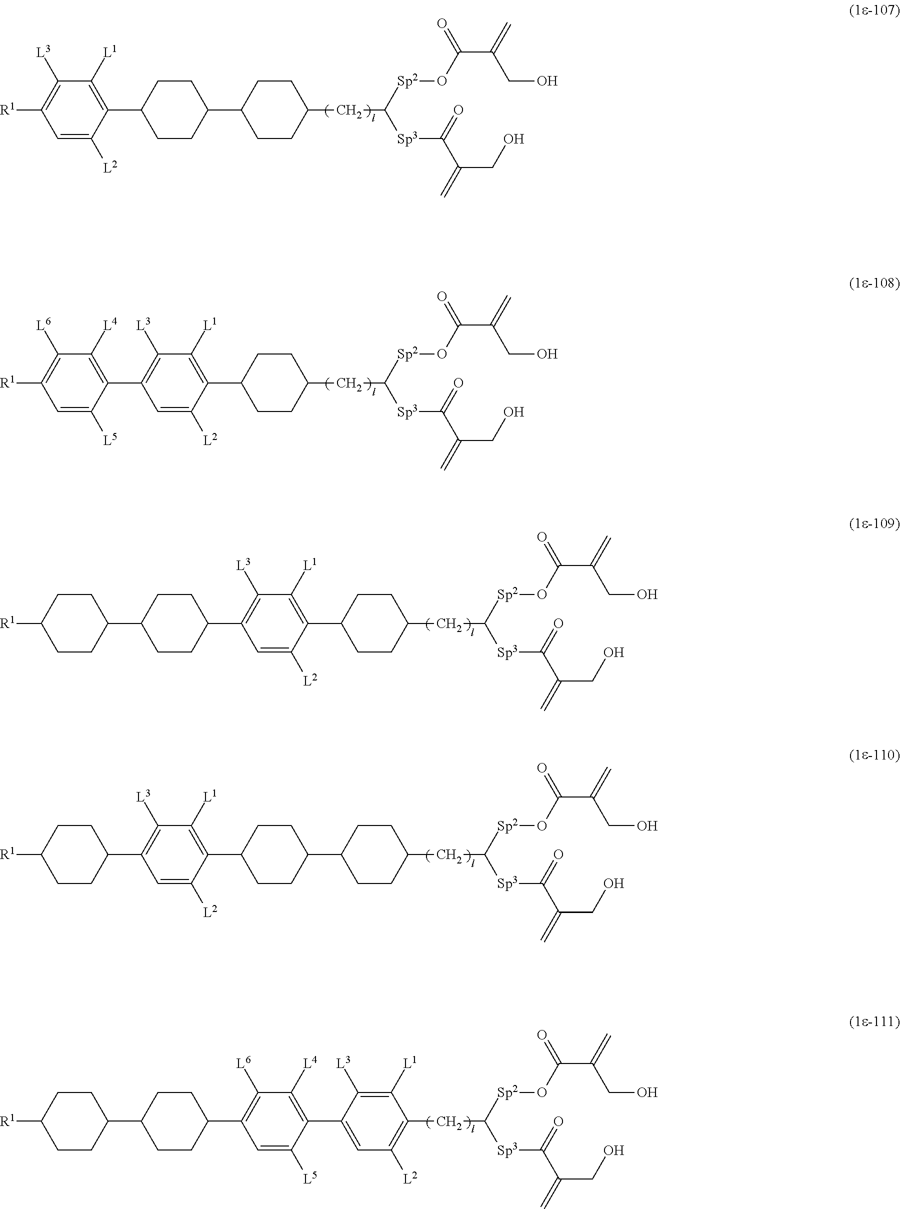

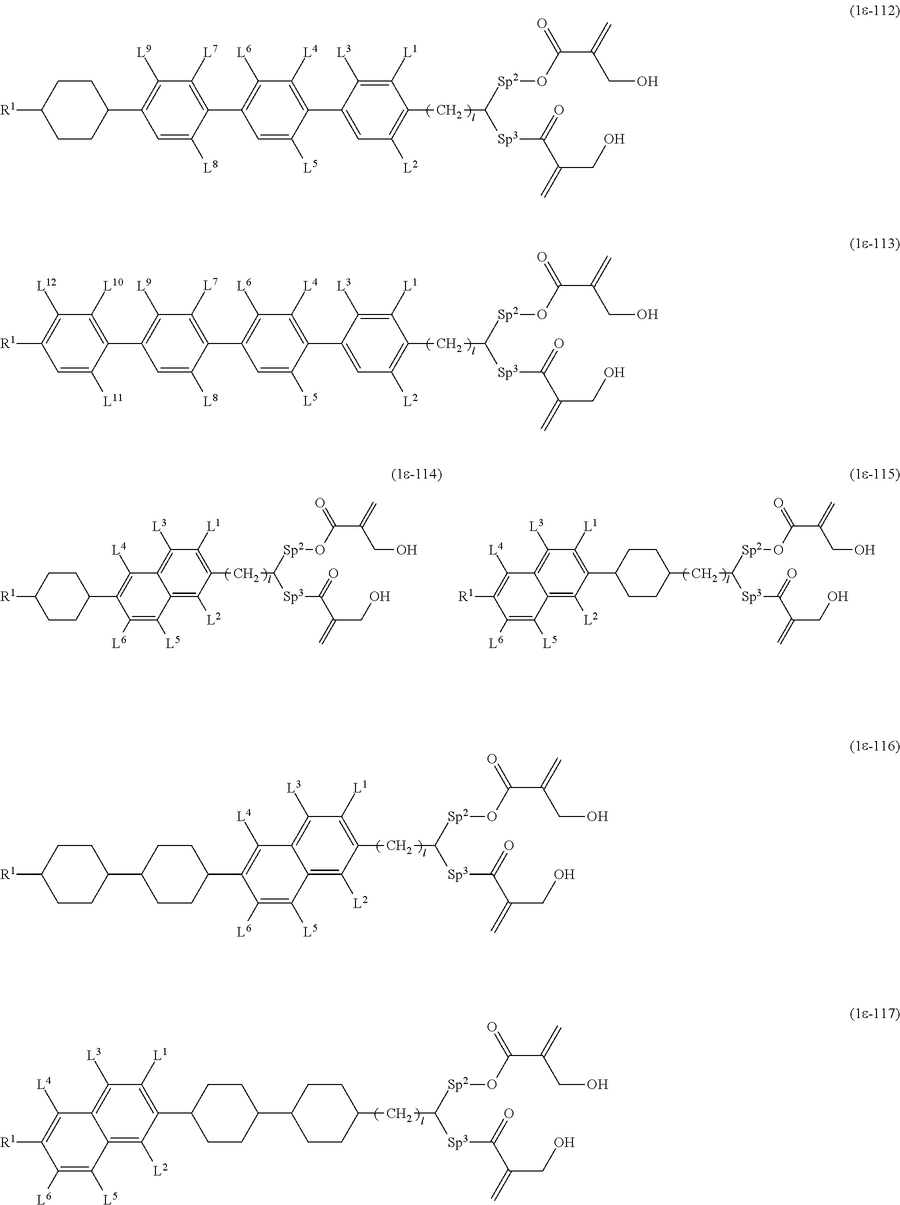

wherein, in formulas (1ε-99) to (1ε-117),

R¹ is alkyl having 1 to 10 carbons;

Sp² and Sp³ are independently alkylene having 1 to 3 carbons, and in the alkylene, at least one —CH₂— may be replaced by —O—;

L¹, L², L³, L⁴, L⁵, L⁶, L⁷, L⁸, L⁹, L¹⁰, L¹¹ and L¹² are independently hydrogen, fluorine or methyl; and

l is 1, 2, 3 or 4, and in the alkylene, at least one —CH₂— may be replaced by —O—.

### 14. Form of Compound (1ε)

Compound (1ε) of the invention has features of having a mesogen moiety formed of at least one ring, and a plurality of polar groups. Compound (1ε) is useful because the polar group noncovalently interacts with a substrate surface of glass (or metal oxide). One of applications is as an additive for the liquid crystal composition used in the liquid crystal display device. Compound (1ε) is added for the purpose of controlling alignment of liquid crystal molecules. Such an additive preferably has high chemical stability under conditions in which the additive is sealed in the device, high solubility in the liquid crystal composition, and the large voltage holding ratio when the liquid crystal composition is used in the liquid crystal display device. Compound (1ε) satisfies such characteristics to a significant extent.

Preferred examples of compound (1ε) will be described. Preferred examples of a symbol such as R¹, MES, Sp¹ and P¹ in compound (1ε) are also applied to a subordinate formula of formula (1ε) for compound (1ε). In compound (1ε), characteristics can be arbitrarily adjusted by suitably combining kinds of the groups. Compound (1ε) may contain a larger amount of isotope such as ²H (deuterium) and ¹³C than an amount of natural abundance because no significant difference exists in the characteristics of the compound.

R¹-MES-Sp¹-P¹ (1ε)

In formula (1ε), R¹ is hydrogen or alkyl having 1 to 15 carbons, and in the alkyl, at least one —CH₂— may be replaced by —O—, —S— or —NH—, and at least one —(CH₂)₂— may be replaced by —CH═CH—, and in the groups, at least one hydrogen may be replaced by halogen.

In formula (1ε), preferred R¹ is hydrogen, alkyl having 1 to 15 carbons, alkenyl having 2 to 15 carbons, alkoxy having 1 to 14 carbons or alkenyloxy having 2 to 14 carbons, and in the groups, at least one hydrogen may be replaced by fluorine or chlorine. Further preferred R¹ is hydrogen, alkyl having 1 to 10 carbons or alkoxy having 1 to 9 carbons, and in the groups, at least one hydrogen may be replaced by fluorine. Particularly preferred R¹ is alkyl having 1 to 10 carbons.

In formula (1ε), MES is a mesogen group having at least one ring. The mesogen group is well known by those skilled in the art. The mesogen group means the part that contributes to formation of the liquid crystal phase when the compound has the liquid crystal phase (mesophase). Preferred examples of compound (1ε) include compound (1ε-1).

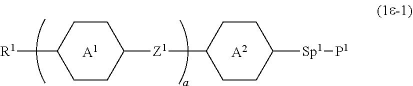

In formula (1ε-1), preferred ring A¹ or ring A² is 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine. Further preferred ring A¹ or ring A² is 1,4-cyclohexylene, 1,4-phenylene, naphthalene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine or alkyl having 1 to 5 carbons. Particularly preferred ring A¹ or ring A² is 1,4-cyclohexylene, 1,4-phenylene, naphthalene-2,6-diyl or perhydrocyclopenta[a]phenanthrene-3,17-diyl, and in the rings, at least one hydrogen may be replaced by fluorine, methyl or ethyl.

In formula (1ε-1), Z¹ is a single bond or alkylene having 1 to 4 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

In formula (1ε-1), preferred Z¹ is a single bond, —(CH₂)₂—, —CH═CH—, —C≡C—, —COO—, —OCO—, —CF₂O—, —OCF₂—, —CH₂O—, —OCH₂— or —CF═CF—. Further preferred Z¹ or Z² is a single bond, —(CH₂)₂—, —COO— or —OCO—. Particularly preferred Z¹ or Z² is a single bond.

In formula (1ε-1), a is 0, 1, 2, 3 or 4. Preferred a is 0, 1, 2 or 3. Further preferred a is 0, 1 or 2. Particularly preferred a is 1 or 2.

In formula (1ε-1), Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen, and in the groups, at least one or more hydrogen is replaced by a polymerizable group represented by formula (1εa):

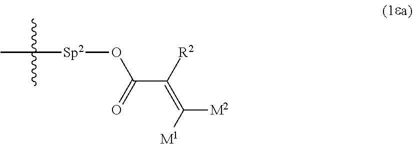

wherein, in formula (1εa),

Sp² is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;

M¹ and M² are independently hydrogen, halogen, alkyl having 1 to 5 carbons, or alkyl having 1 to 5 carbons in which at least one hydrogen is replaced by halogen; and

R² is hydrogen or alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

In formula (1ε-1), preferred Sp¹ is alkylene having 1 to 5 carbons, or alkylene having 1 to 5 carbons in which one —CH₂— is replaced by —O—. Further preferred Sp¹ is alkylene having 1 to 3 carbons, or alkylene having 1 to 3 carbons in which one —CH₂— is replaced by —O—, and in the groups, at least one hydrogen is replaced by a polymerizable group represented by formula (1εa).

In formula (1εa), preferred Sp² is a single bond, alkylene having 1 to 5 carbons, or alkylene having 1 to 5 carbons in which one —CH₂— is replaced by —O—. Further preferred Sp¹ is a single bond, alkylene having 1 to 3 carbons, or alkylene having 1 to 3 carbons in which one —CH₂— is replaced by —O—.

In formula (1εa), preferred R² is hydrogen, alkylene having 1 to 5 carbons, or alkylene having 1 to 5 carbons in which one —CH₂— is replaced by —O—. Further preferred R² is hydrogen, alkylene having 1 to 3 carbons, or alkylene having 1 to 3 carbons in which one —CH₂— is replaced by —O—. Particularly preferred R² is hydrogen or methyl. When R² is —CH₂—OH, vertical alignment in low-concentration addition is expected by an effect in which two hydroxyl groups exist in a molecule.

In formula (1εa), M¹ and M² are independently hydrogen, halogen, alkyl having 1 to 5 carbons, or alkyl having 1 to 5 carbons in which at least one hydrogen is replaced by halogen. Preferred M¹ or M² is hydrogen or methyl for increasing reactivity. Further preferred M¹ or M² is hydrogen.

In formula (1ε), P¹ is a group selected from the group of groups represented by formulas (1εe) and (1εf):

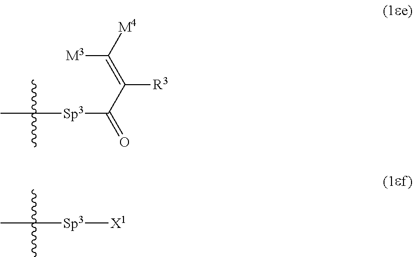

wherein, in formula (1εe), R³ is a group selected from the group of groups represented by formulas (1εg), (1εh) and (1εi).

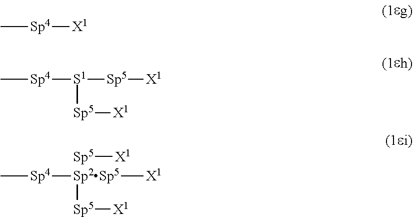

In formulas (1εe) and (1εf), preferred Sp³ is alkylene having 1 to 7 carbons, or alkylene having 1 to 5 carbons in which one —CH₂— is replaced by —O—. Further preferred Sp³ is alkylene having 1 to 5 carbons, or alkylene having 1 to 5 carbons in which one —CH₂— is replaced by —O—. Particularly preferred Sp³ is —CH₂—.

In formula (1εe), M³ and M⁴ are independently hydrogen, halogen, alkyl having 1 to 5 carbons, or alkyl having 1 to 5 carbons in which at least one hydrogen is replaced by halogen. Preferred M³ or M⁴ is hydrogen or methyl for increasing reactivity. Further preferred M³ or M⁴ is hydrogen.

In formula (1εe), preferred R³ is a group selected from the group of polar groups represented by formulas (1εg), (1εh) and (1εi). Preferred R³ is a polar group represented by formula (1g) or (1h). Further preferred R³ is a polar group represented by formula (1g).

In formulas (1εg), (1εh) and (1εi), preferred Sp⁴ or Sp⁵ is alkylene having 1 to 7 carbons, or alkylene having 1 to 5 carbons in which one —CH₂— is replaced by —O—. Further preferred Sp⁴ or Sp⁵ is alkylene having 1 to 5 carbons, or alkylene having 1 to 5 carbons in which one —CH₂— is replaced by —O—. Particularly preferred Sp⁴ or Sp⁵ is —CH₂—.

In formulas (1εg) and (1εi), S¹ is >CH— or >N—, and S² is >C< or >Si<. Preferred S¹ is >CH—, and preferred S² is >C<.

In formulas (1εf), (1εg) and (1εi), X¹ is —OH, —NH₂, —OR⁵, —N(R⁵)₂, —COOH, —SH, —B(OH)₂ or —Si(R⁵)₃, in which R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by fluorine or chlorine.

Preferred X¹ is —OH, —NH₂ or —N(R⁵)₂, in which R⁵ is alkyl having 1 to 5 carbons or alkoxy having 1 to 4 carbons. Further preferred X¹ is —OH, —NH₂ or —N(R⁵)₂. Particularly preferred X¹ is —OH.

### 15. Synthesis of Compound (1ε)

Synthesis methods of compound (1ε) will be described. Compound (1ε) can be synthesized by suitably combining methods in synthetic organic chemistry. Any compounds whose synthetic methods are not described are prepared according to methods described in books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

Formation of a Bonding Group

An example of a method for forming a bonding group in compound (1ε) is as described in a scheme below. In the scheme, MSG¹ (or MSG²) is a monovalent organic group having at least one ring. Monovalent organic groups represented by a plurality of MSG¹ (or MSG²) may be identical or different. Compounds (1A) to (1G) correspond to compound (1ε) or an intermediate of compound (1ε).

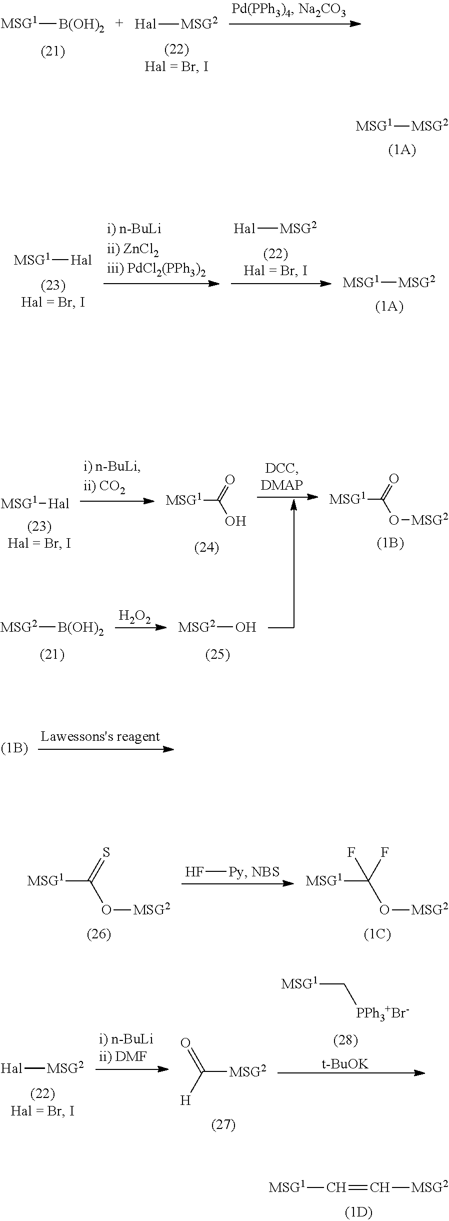

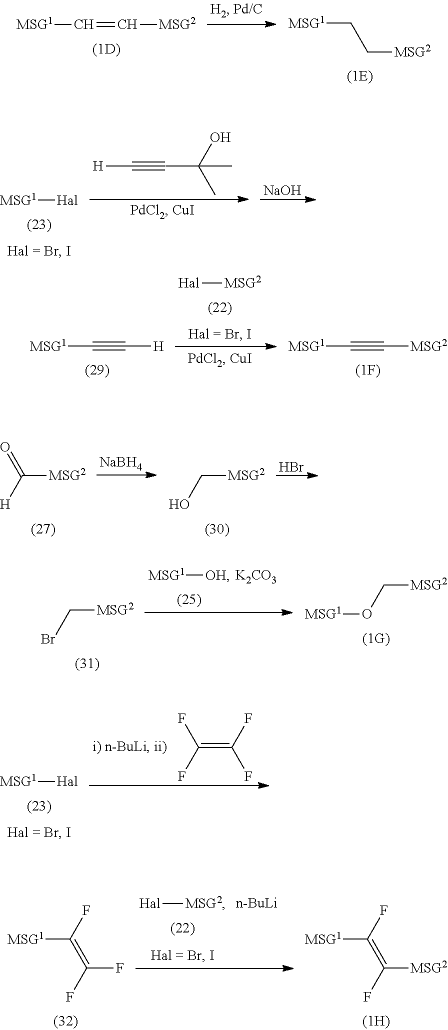

### (I) Formation of a Single Bond

Compound (1A) is prepared by allowing aryl boronic acid (21) to react with compound (22) in the presence of a carbonate and a tetrakis(triphenylphosphine)palladium catalyst. Compound (1A) is also prepared by allowing compound (23) to react with n-butyllithium and subsequently with zinc chloride, and further with compound (22) in the presence of a dichlorobis(triphenylphosphine)palladium catalyst.

### (II) Formation of —COO— and —OCO—

Carboxylic acid (24) is obtained by allowing compound (23) to react with n-butyllithium and subsequently with carbon dioxide. Compound (1B) having —COO— is prepared by dehydration of carboxylic acid (24) and phenol (25) derived from compound (21) in the presence of 1,3-dicyclohexylcarbodiimide (DCC) and 4-dimethylaminopyridine (DMAP). A compound having —OCO— is also prepared according to the method.

(III) Formation of —CF₂O— and —OCF₂—

Compound (26) is obtained by sulfurizing compound (1B) with a Lawesson's reagent. Compound (1C) having —CF₂O— is prepared by fluorinating compound (26) with a hydrogen fluoride-pyridine complex and N-bromosuccinimide (NBS). Refer to M. Kuroboshi et al., Chem. Lett., 1992, 827. Compound (1C) is also prepared by fluorinating compound (26) with (diethylamino)sulfur trifluoride (DAST). Refer to W. H. Bunnelle et al., J. Org. Chem. 1990, 55, 768. A compound having —OCF₂— is also prepared according to the method.

### (IV) Formation of —CH═CH—

Aldehyde (27) is obtained by allowing compound (22) to react with n-butyllithium and subsequently with N,N-dimethylformamide (DMF). Compound (1D) is prepared by allowing phosphorus ylide generated by allowing phosphonium salt (28) to react with potassium t-butoxide to react with aldehyde (27). A cis isomer may be generated depending on reaction conditions, and therefore the cis isomer is isomerized into a trans isomer according to a publicly-known method when necessary.

(V) Formation of —CH₂CH₂—

Compound (1E) is prepared by hydrogenating compound (1D) in the presence of a palladium on carbon catalyst.

### (VI) Formation of —C≡C—

Compound (29) is obtained by allowing compound (23) to react with 2-methyl-3-butyn-2-ol in the presence of a catalyst of dichloropalladium and copper iodide and then performing deprotection of the resulting compound under basic conditions. Compound (1F) is prepared by allowing compound (29) to react with compound (22) in the presence of a catalyst of dichlorobis (triphenylphosphine)palladium and copper halide.

(VII) Formation of —CH₂O— and —OCH₂—

Compound (30) is obtained by reducing compound (27) with sodium borohydride. Compound (31) is obtained by brominating the obtained compound with hydrobromic acid. Compound (1G) is prepared by allowing compound (25) to react with compound (31) in the presence of potassium carbonate. A compound having —OCH₂— is also prepared according to the method.

### (VIII) Formation of —CF═CF—

Compound (32) is obtained by treating compound (23) with n-butyllithium and then allowing the treated compound to react with tetrafluoroethylene. Compound (1H) is prepared by treating compound (22) with n-butyllithium and then allowing the treated compound to react with compound (32).

Formation of Ring A²

A starting material is commercially available or a synthetic method is well known with regard to a ring such as 1,4-cyclohexylene, 1,4-cyclohexenylene, 1,4-phenylene, 2-fluoro-1,4-phenylene, 2-methyl-1,4-phenylene, 2-ethyl-1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl and pyridine-2,5-diyl.

### Synthesis Example

An example of a method for preparing compound (1ε) is as described below. In the compounds, definitions of R¹, MES, M¹ and M² are identical to definitions described in item 81.

Compounds (1ε-51) and (1ε-52) in which R² is a group represented by formula (1εa), Sp⁴ is —CH₂—, and X¹ is —OH can be prepared according to a method described below.

Compound (52) is obtained by allowing compound (51) to react in the presence of formaldehyde and 1,4-diazabicyclo[2.2.2]octane (DABCO). Compound (53) is obtained by allowing compound (52) to react in the presence of pyridinium p-toluenesulfonate (PPTS) and 3,4-dihydro-2H-pyran.

Compound (1ε-51) can be obtained by allowing compound (54) to react in the presence of triethylamine (Et₃N) and methacryloyl chloride. Compound (55) is obtained by allowing compound (1ε-51) to react with compound (53) in the presence of DCC and DMAP, and then compound (1ε-52) can be derived by performing deprotection of compound (55) by using tetrabutylammonium fluoride (PPTS).

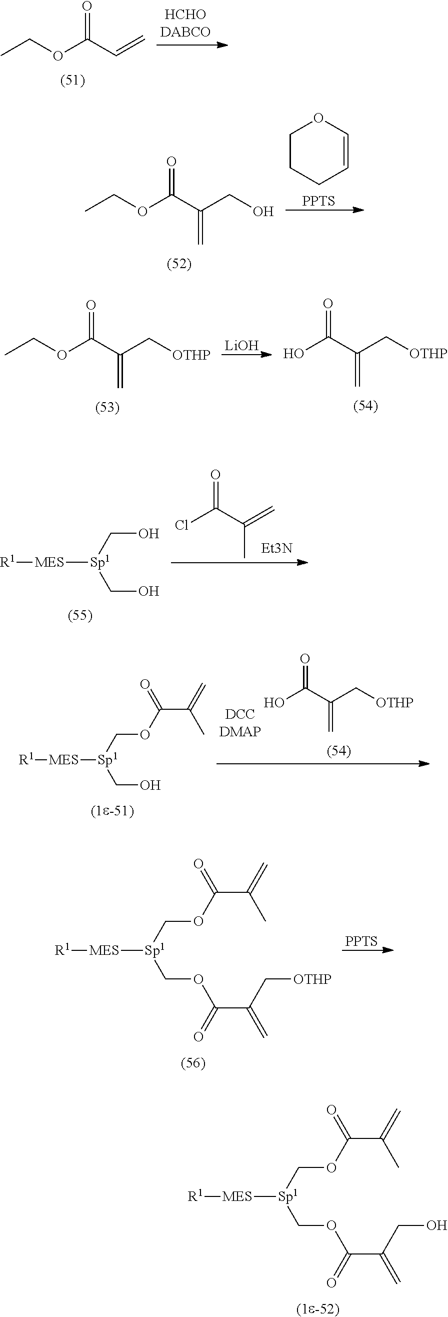

Compounds (1ε-53) in which R² is a group represented by formula (1εa), Sp⁴ is —(CH₂)₂—, and X¹ is —OH can be prepared according to a method described below. Compound (56) is obtained by allowing phosphorus tribromide to act on compound (1ε-52). Next, compound (1ε-53) can be derived by allowing indium to act on compound (57) and then allowing the resulting compound to react with formaldehyde.

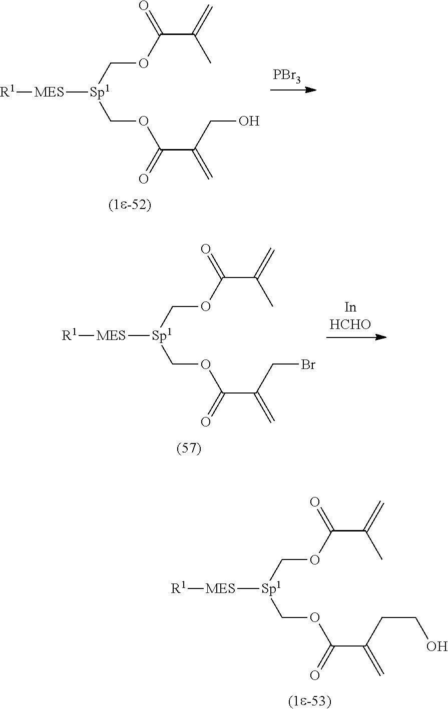

Compounds (1ε-54) in which R² is a group represented by formula (1εa), Sp⁴ is —CH₂—, and X¹ is —OH can be prepared according to a method described below.

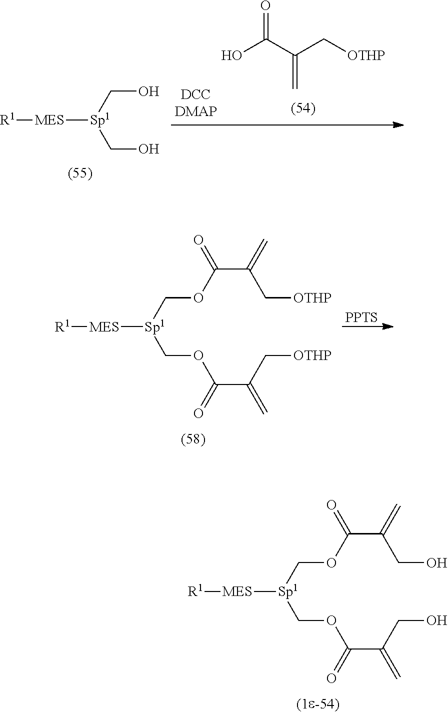

### 16. Liquid Crystal Composition

The liquid crystal composition contains compound (1) that functions as the alignable monomer, more specifically, contains at least one polymerizable polar compound of compounds (1α), (1γ), (1β), (1δ) and (1ε) as component A. Compound (1) noncovalently interacts with a substrate of a device, and thus can control alignment of liquid crystal molecules.

The composition contains compound (1) as component A, and preferably further contains a liquid crystal compound selected from components B, C, D and E described below.

Component B includes compounds (2) to (4).

Component C includes compounds (5) to (7).

Component D includes compound (8).

Component E includes compounds (9) to (15).

The composition may contain any other liquid crystal compound different from compounds (2) to (15). When the composition is prepared, components B, C, D and E are preferably selected by considering magnitude of positive or negative dielectric anisotropy, or the like. A composition in which components thereof are suitably selected has high maximum temperature, low minimum temperature, small viscosity, suitable optical anisotropy (more specifically, large optical anisotropy or small optical anisotropy), large positive or negative dielectric anisotropy, large specific resistance, stability to heat or ultraviolet light and a suitable elastic constant (more specifically, a large elastic constant or a small elastic constant).

Compound (16) that functions as a reactive monomer may be added to the composition for the purpose of increasing reactivity (polymerizability).

A preferred proportion of compound (1) is about 0.01% by weight or more for maintaining high stability to ultraviolet light, and about 5% by weight or less for dissolution in the liquid crystal composition. A further preferred proportion is in the range of about 0.05% by weight to about 2% by weight. A most preferred proportion is in the range of about 0.05% by weight to about 1% by weight.

In addition, a preferred proportion of compound (1δ) or (1ε) is about 0.05% by weight or more, and about 10% by weight or less for preventing poor display in the device. A further preferred proportion is in the range of about 0.1% by weight to about 7% by weight. A particularly preferred proportion is in the range of about 0.5% by weight to about 5% by weight.

In addition, a preferred proportion when adding compound (16) is in the range of 0.01% by weight to 1.0% by weight.

Component B includes a compound in which two terminal groups are alkyl or the like. Preferred examples of component B include compounds (2-1) to (2-11), compounds (3-1) to (3-19) and compounds (4-1) to (4-7). In a compound of component B, R¹¹ and R¹² are independently alkyl having 1 to 10 carbons or alkenyl having 2 to 10 carbons, and in the alkyl or the alkenyl, at least one —CH₂— may be replaced by —O—, and at least one hydrogen may be replaced by fluorine.

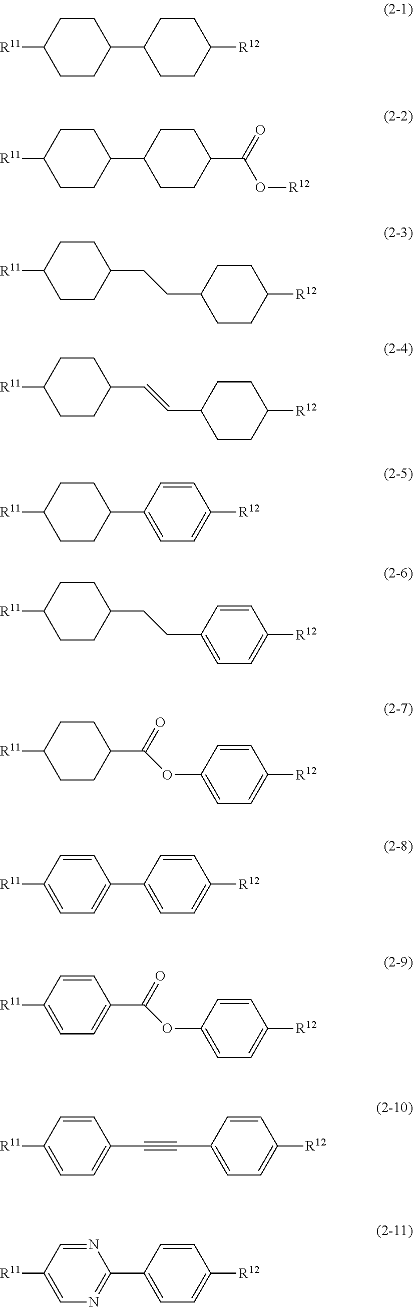

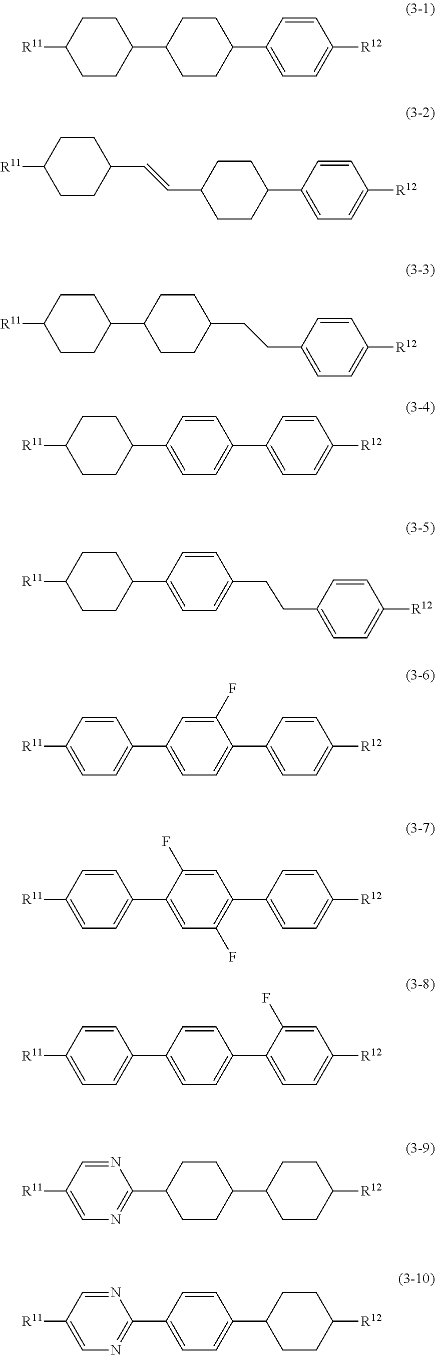

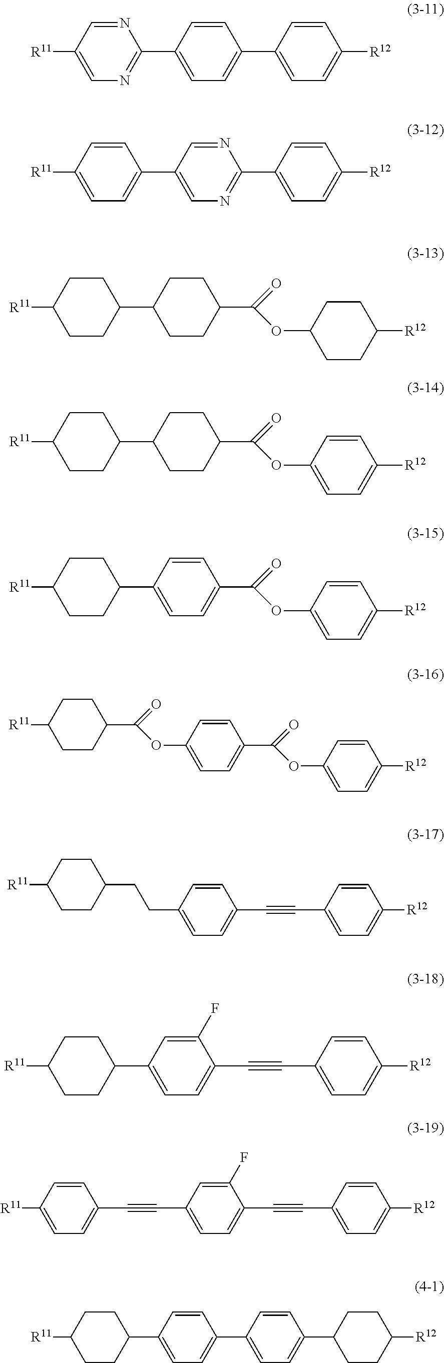

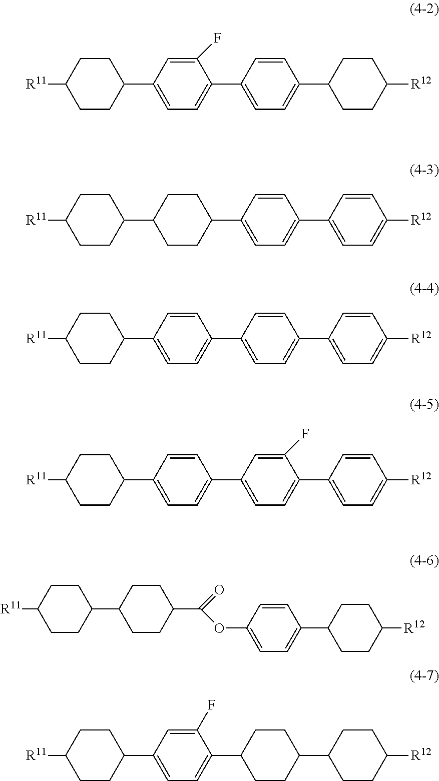

Component B has a small absolute value of dielectric anisotropy, and therefore is a compound close to neutrality. Compound (2) is mainly effective in decreasing the viscosity or adjusting optical anisotropy. Compounds (3) and (4) are effective in extending the temperature range of the nematic phase by increasing the maximum temperature, or in adjusting the optical anisotropy.

As a content of component B is increased, the dielectric anisotropy of the composition is decreased, but the viscosity is decreased. Thus, as long as a desired value of threshold voltage of the device is met, the content is preferably as large as possible. When a composition for an IPS mode, a VA mode or the like is prepared, the content of component B is preferably 30% by weight or more, and further preferably 40% by weight or more, based on the weight of the liquid crystal composition.

Component C is a compound having a halogen-containing group or a fluorine-containing group at a right terminal. Preferred examples of component C include compounds (5-1) to (5-16), compounds (6-1) to (6-113) and compounds (7-1) to (7-57). In a compound of component C, R¹³ is alkyl having 1 to 10 carbons or alkenyl having 2 to 10 carbons, and in the alkyl and the alkenyl, at least one —CH₂— may be replaced by —O—, and at least one hydrogen may be replaced by fluorine; and X¹¹ is fluorine, chlorine, —OCF₃, —OCHF₂, —CF₃, —CHF₂, —CH₂F, —OCF₂CHF₂ or —OCF₂CHFCF₃.

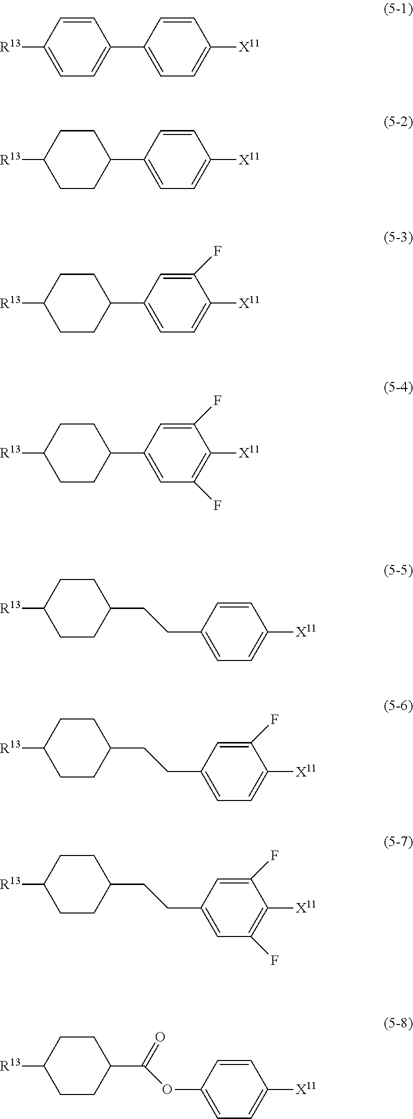

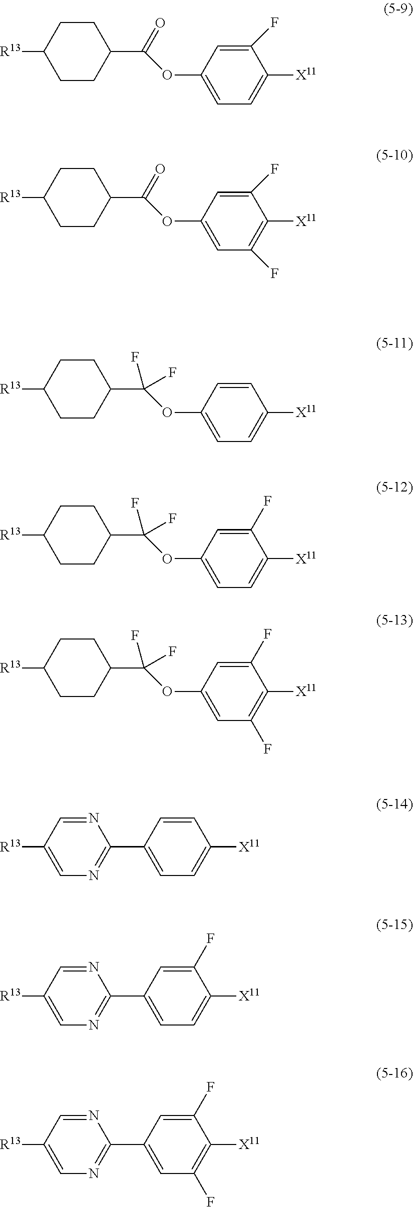

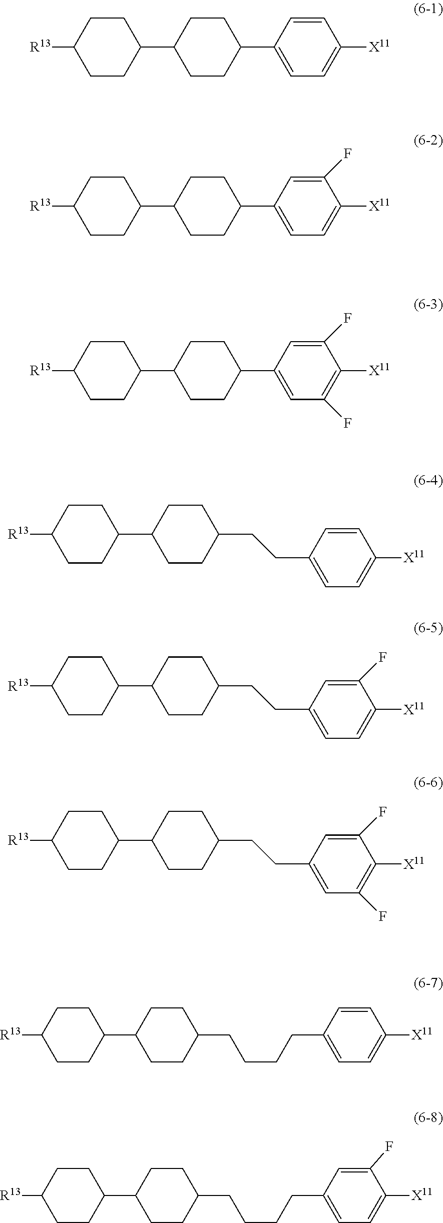

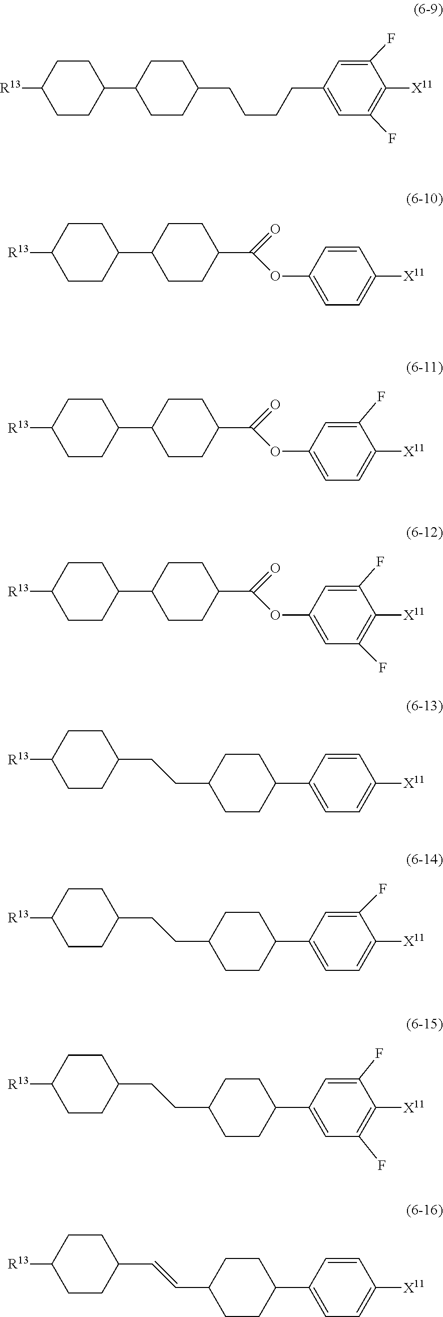

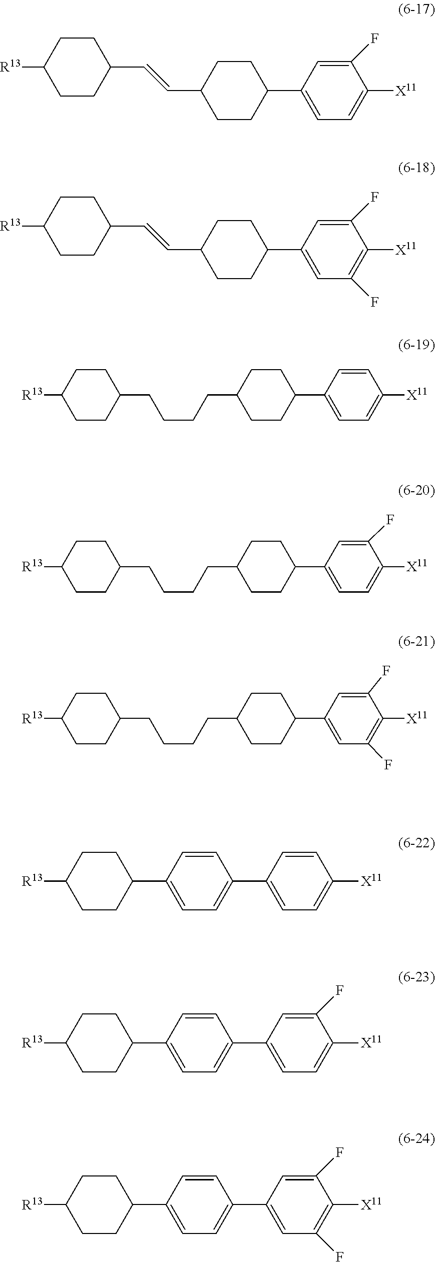

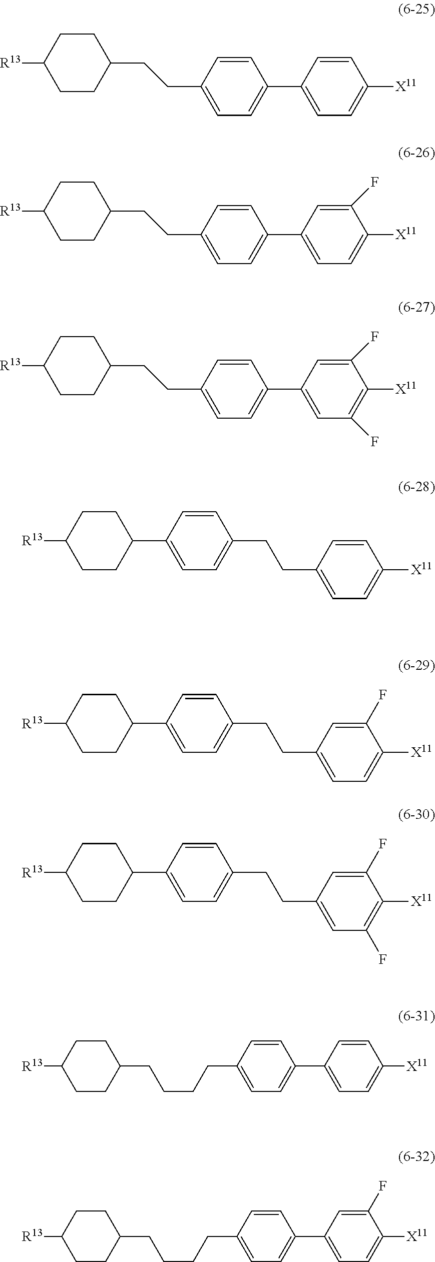

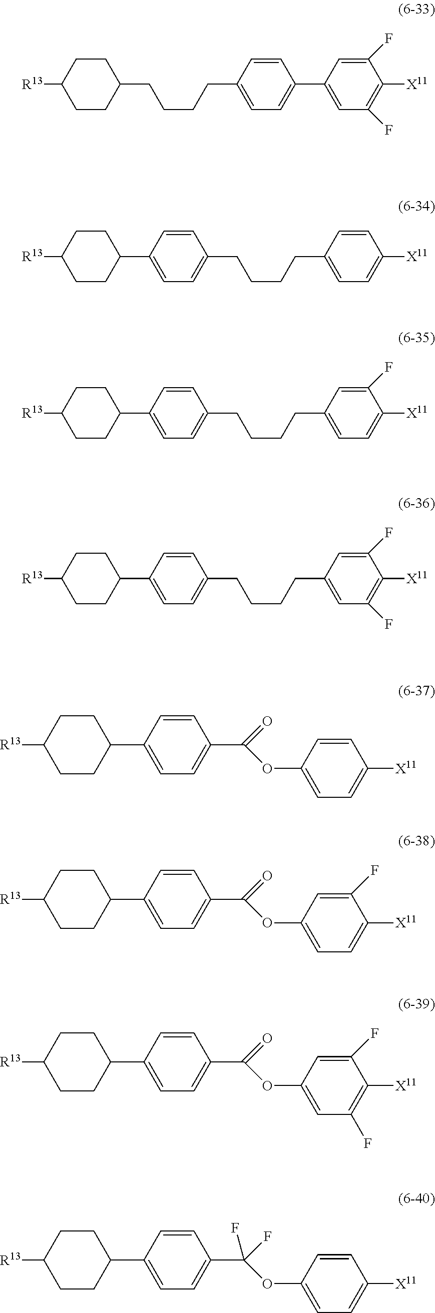

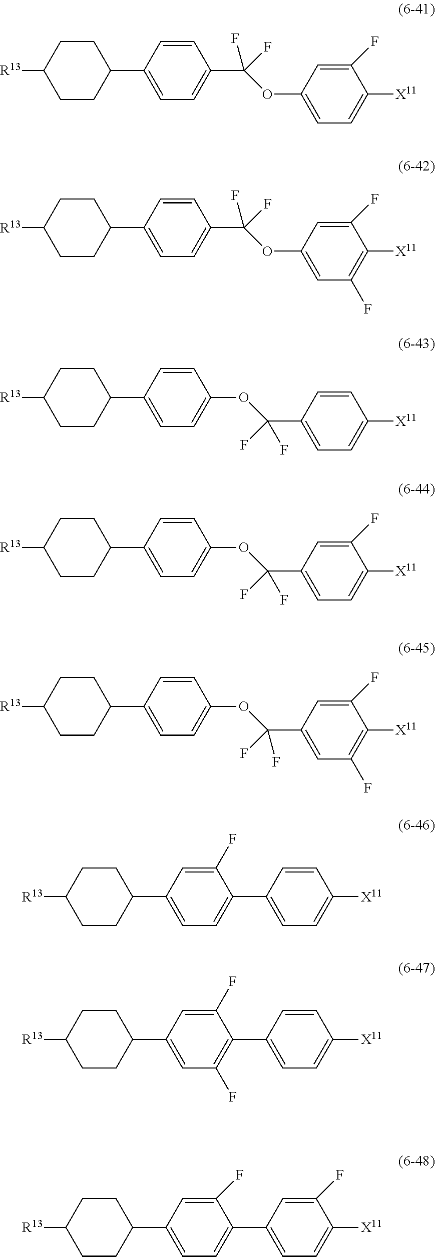

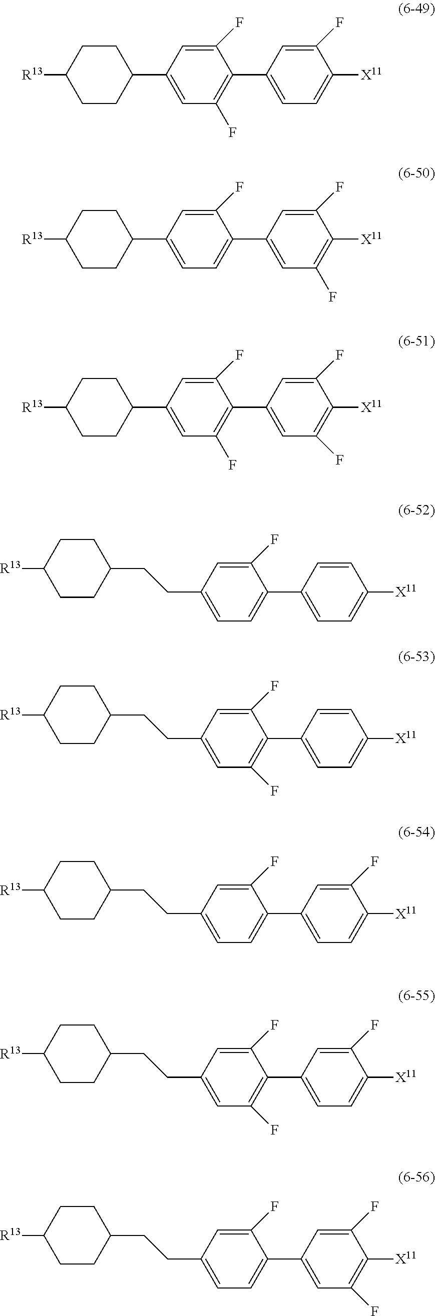

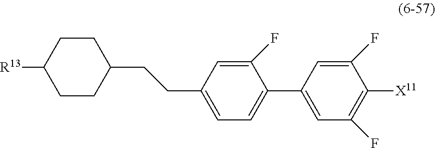

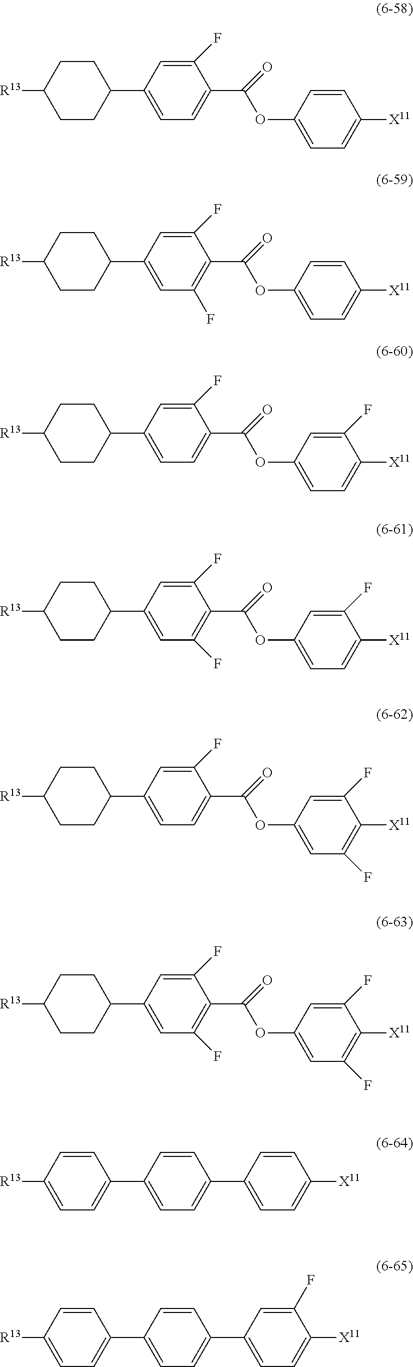

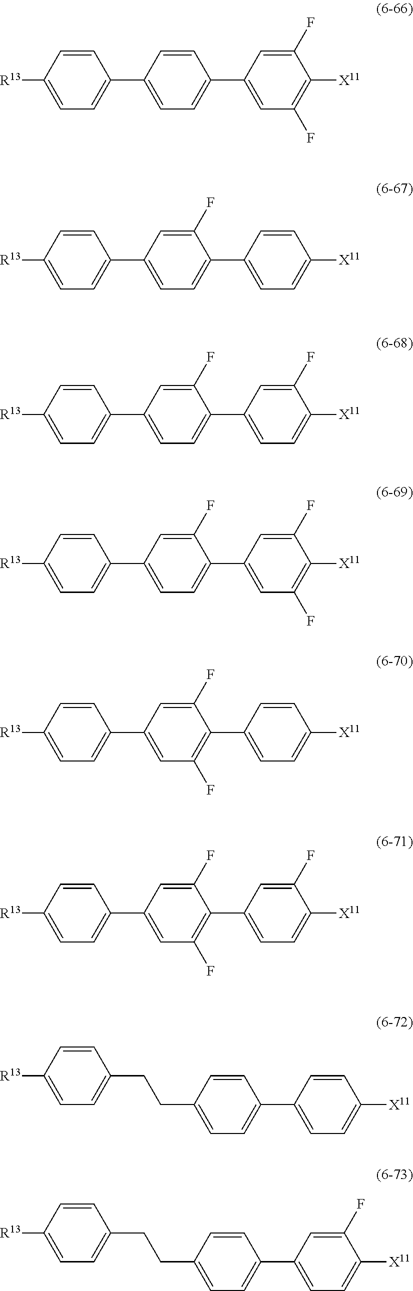

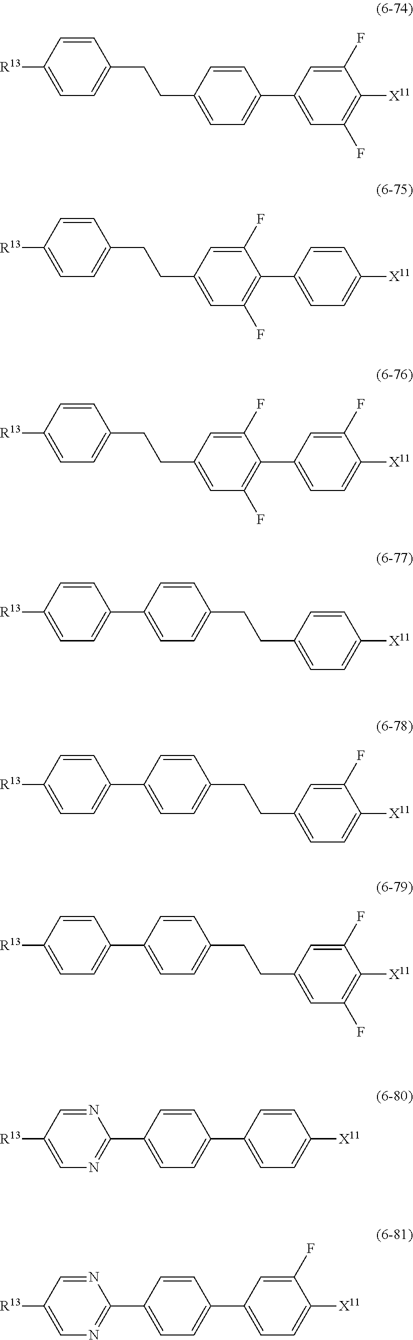

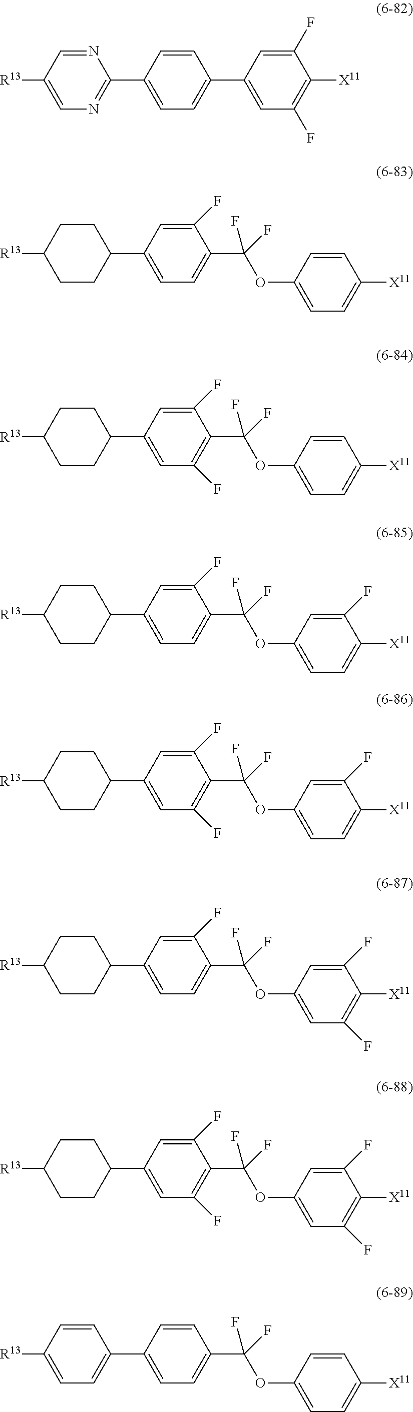

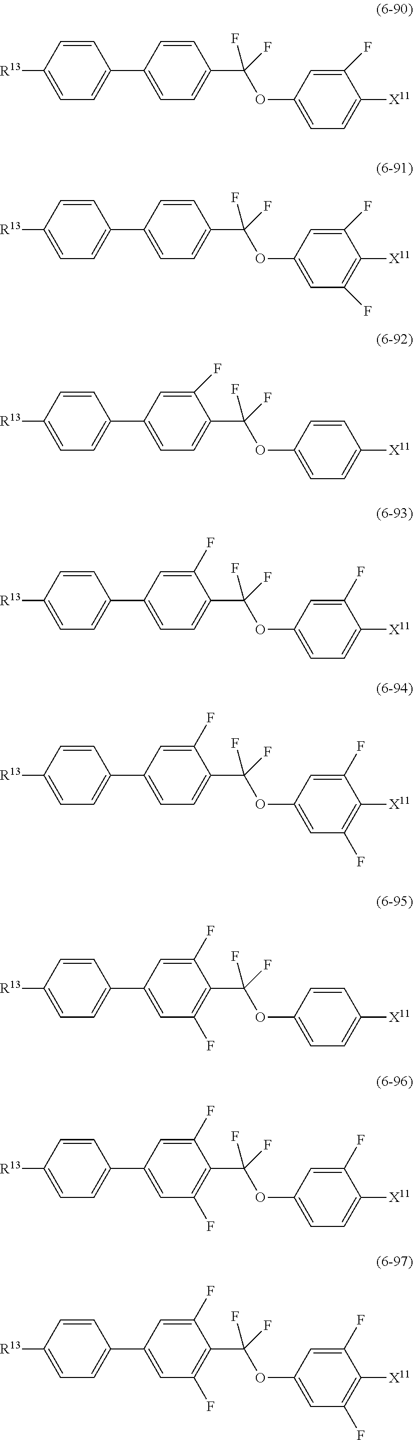

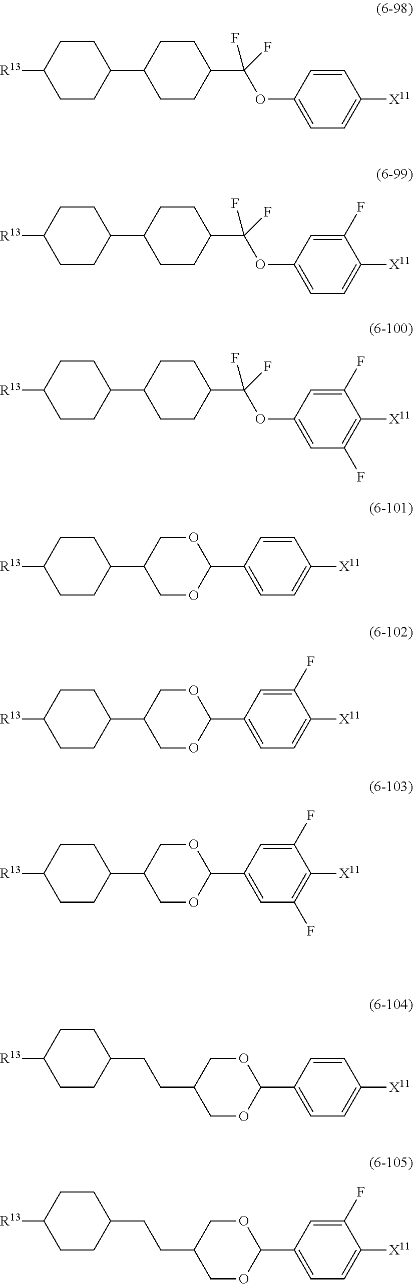

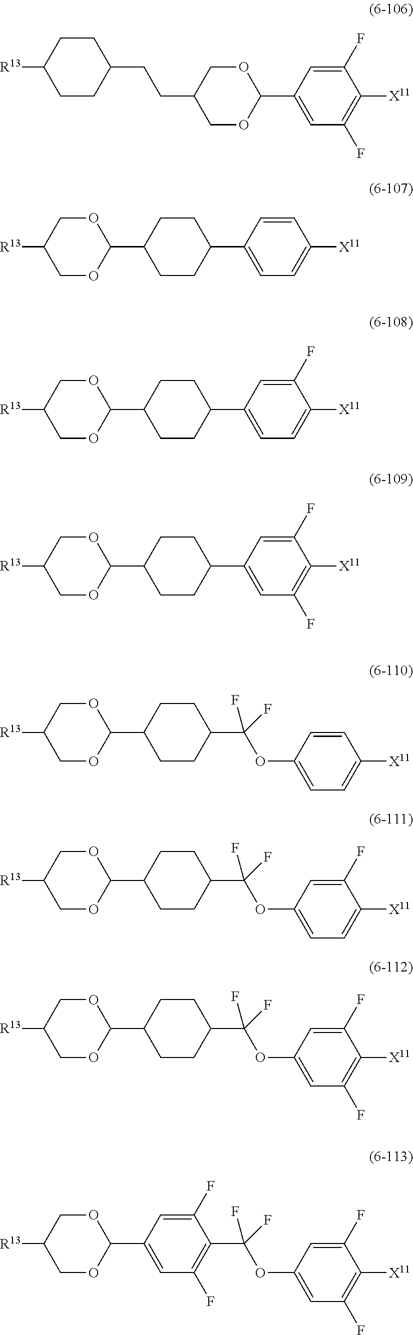

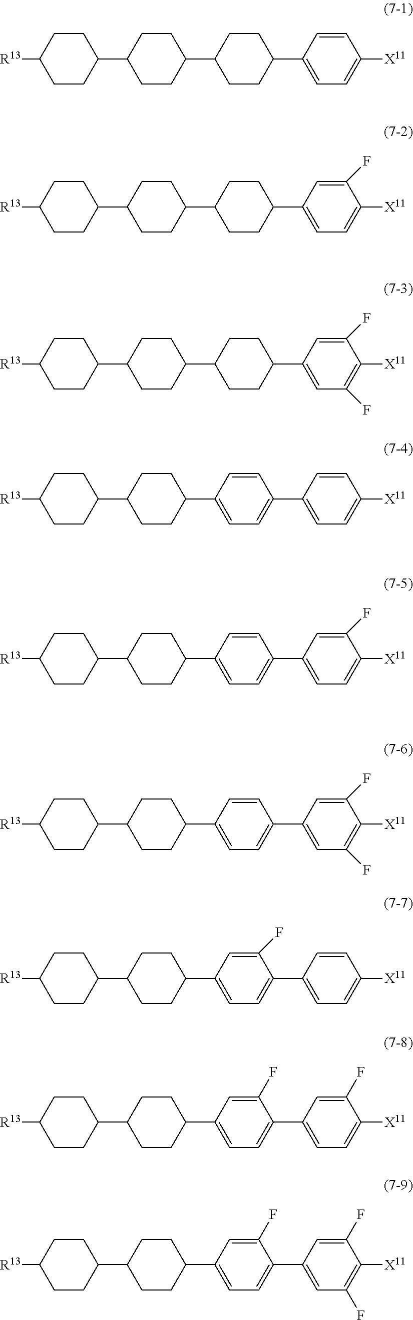

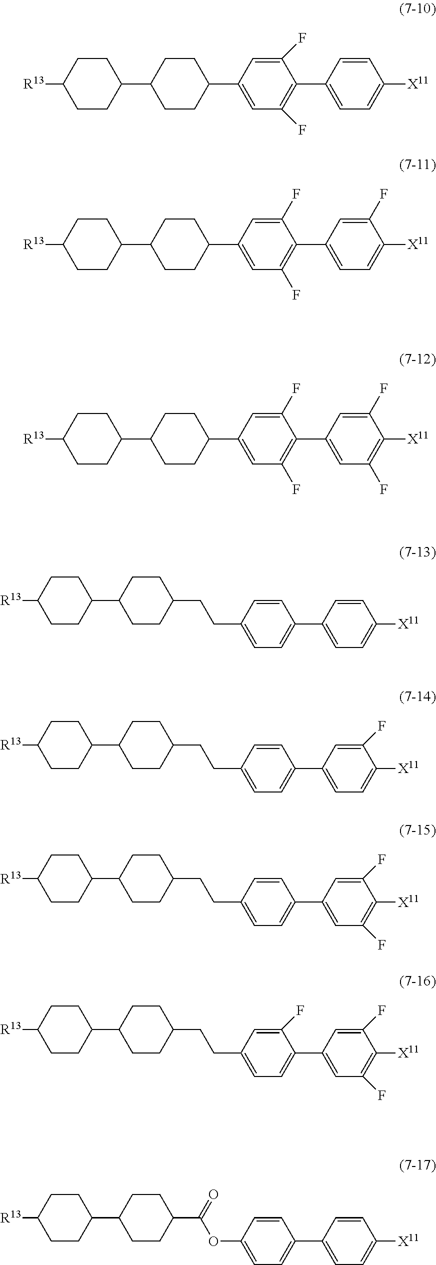

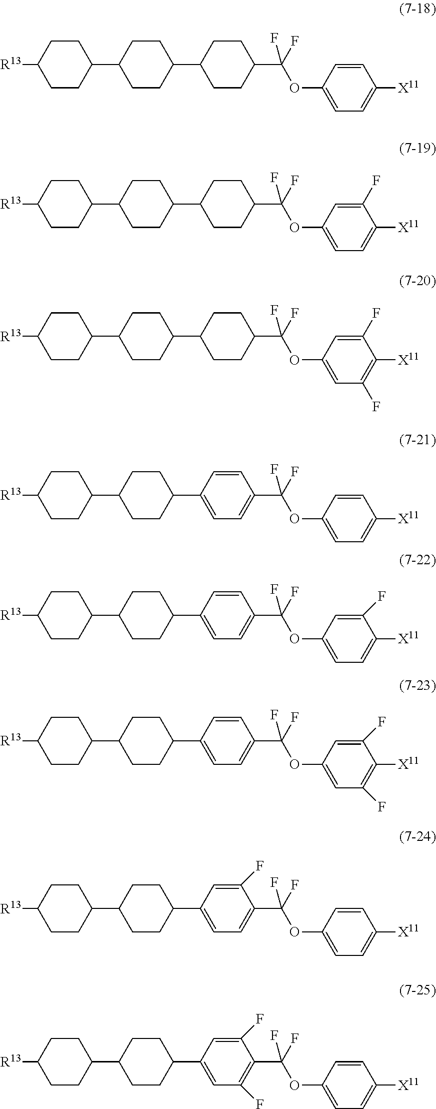

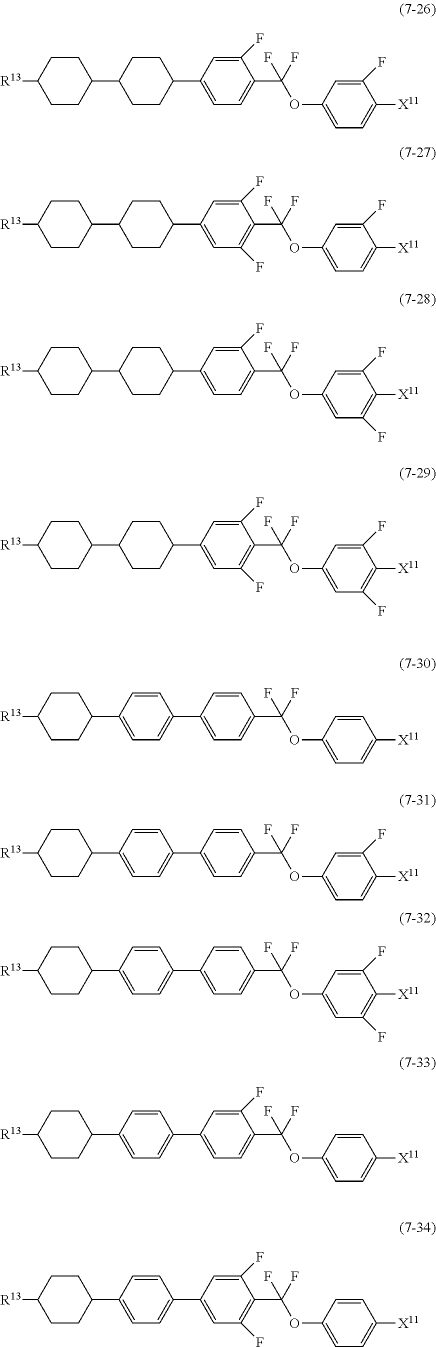

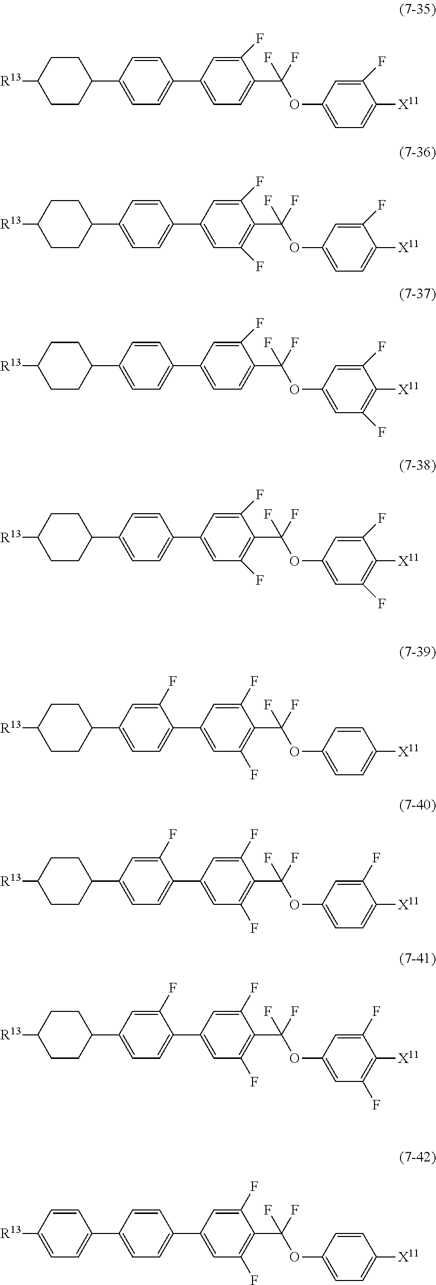

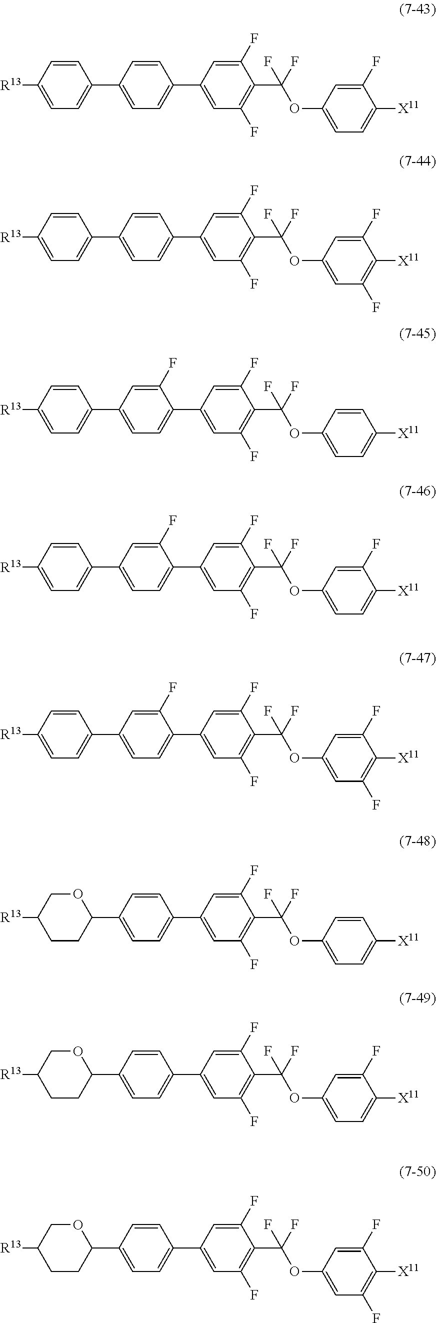

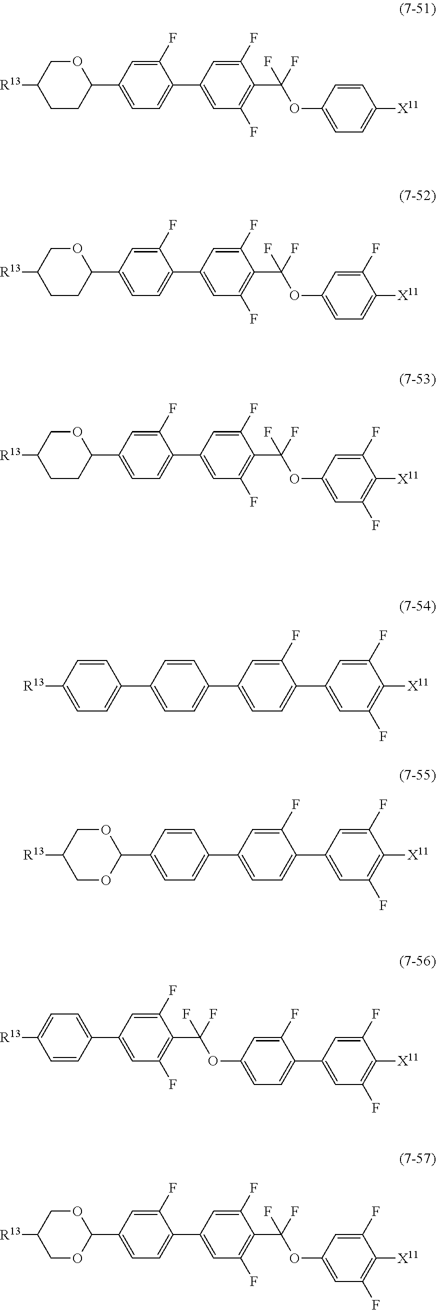

Component C has positive dielectric anisotropy, and superb stability to heat, light and so forth, and therefore is used when a composition for the IPS mode, an FFS mode, an OCB mode or the like is prepared. A content of component C is suitably in the range of 1% by weight to 99% by weight, preferably in the range of 10% by weight to 97% by weight, and further preferably in the range of 40% by weight to 95% by weight, based on the weight of the liquid crystal composition. When component C is added to a composition having negative dielectric anisotropy, the content of component C is preferably 30% by weight or less based on the weight of the liquid crystal composition. Addition of component C allows adjustment of the elastic constant of the composition and adjustment of a voltage-transmittance curve of the device.

Component D is compound (8) in which a right-terminal group is —C≡N or —C≡C—C≡N. Preferred examples of component D include compounds (8-1) to (8-64). In a compound of component D, R¹⁴ is alkyl having 1 to 10 carbons or alkenyl having 2 to 10 carbons, and in the alkyl and the alkenyl, at least one —CH₂— may be replaced by —O—, and at least one hydrogen may be replaced by fluorine; and —X¹² is —C≡N or —C≡C—C≡N.

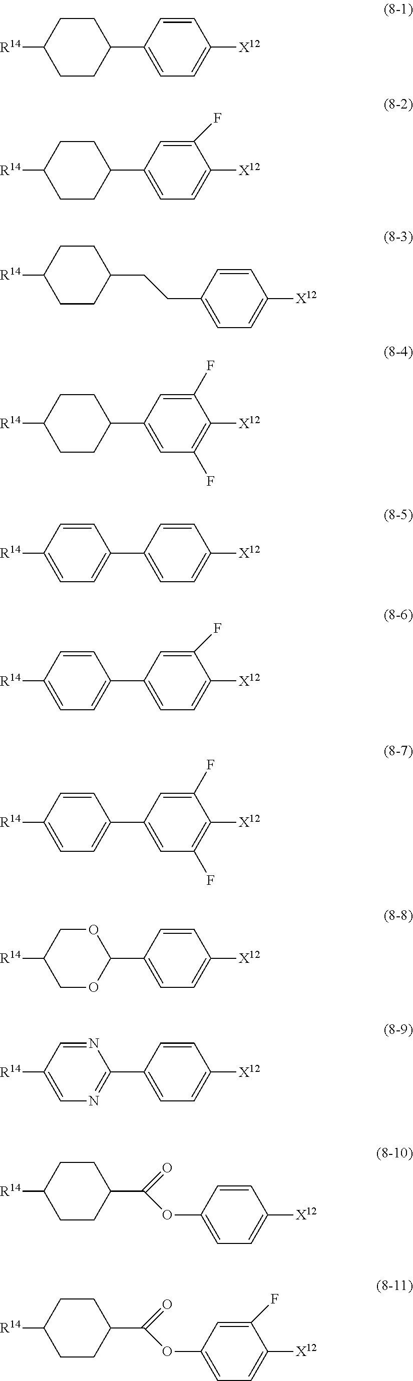

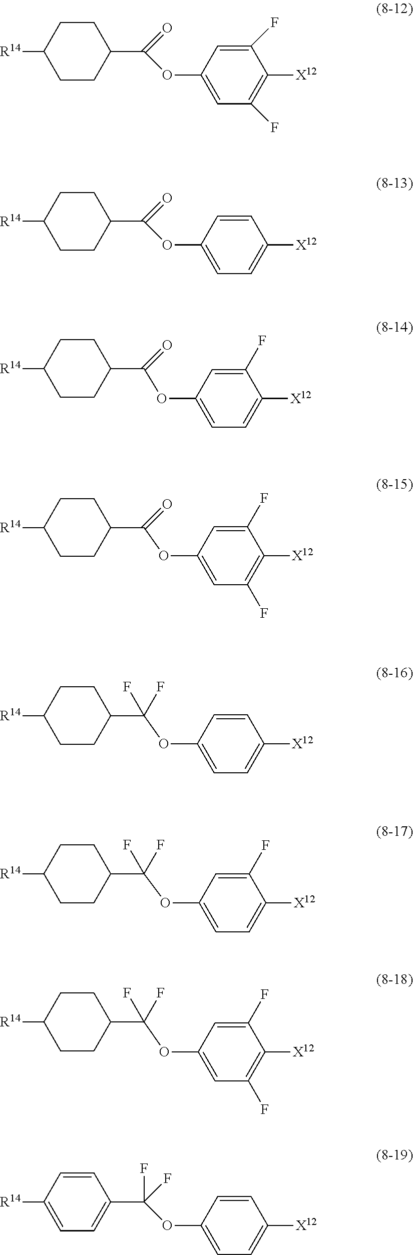

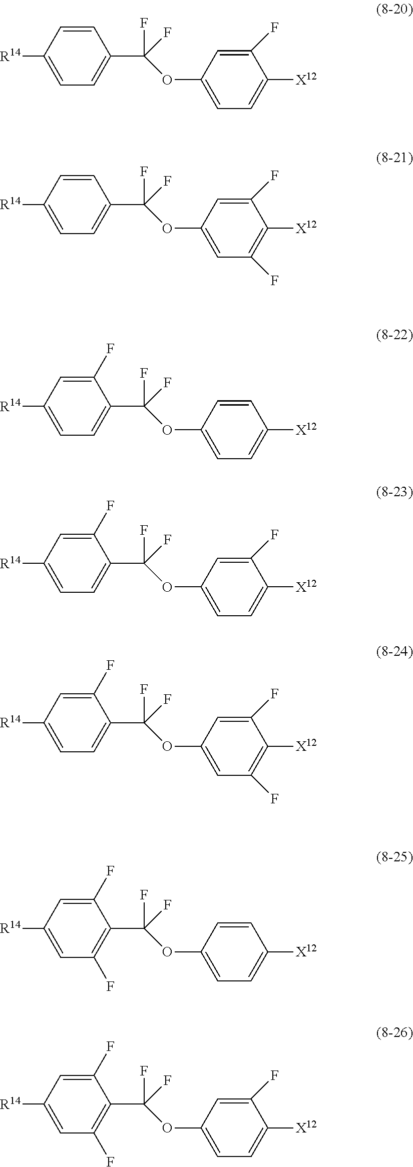

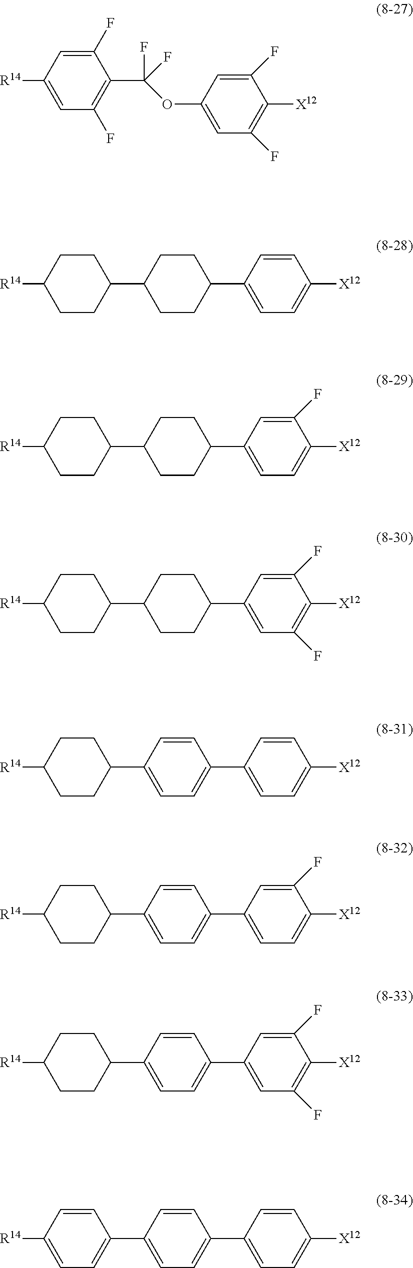

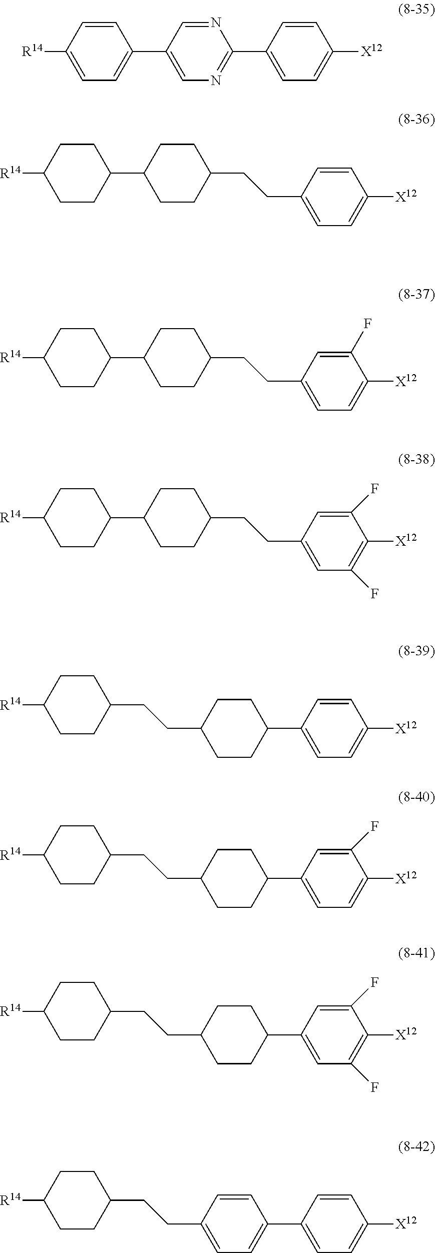

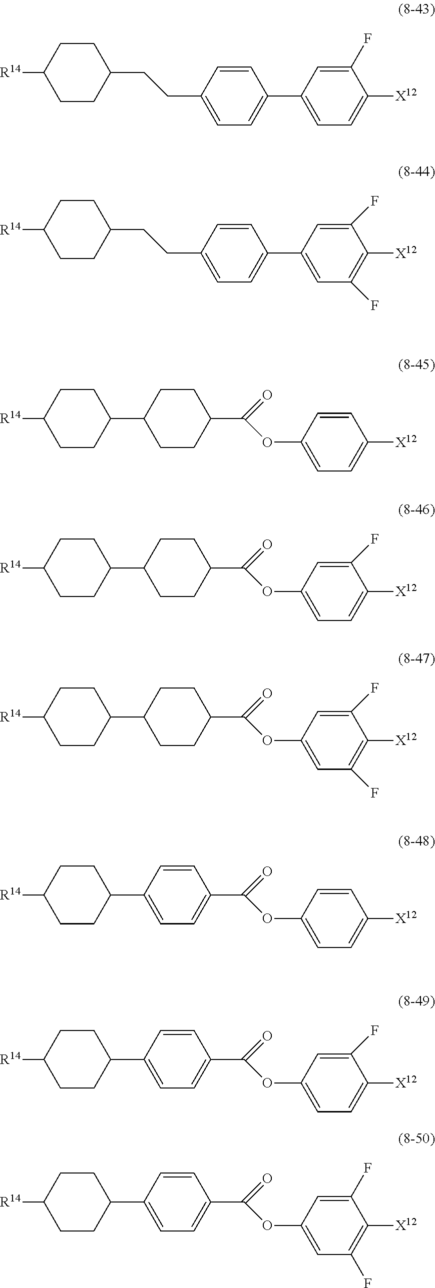

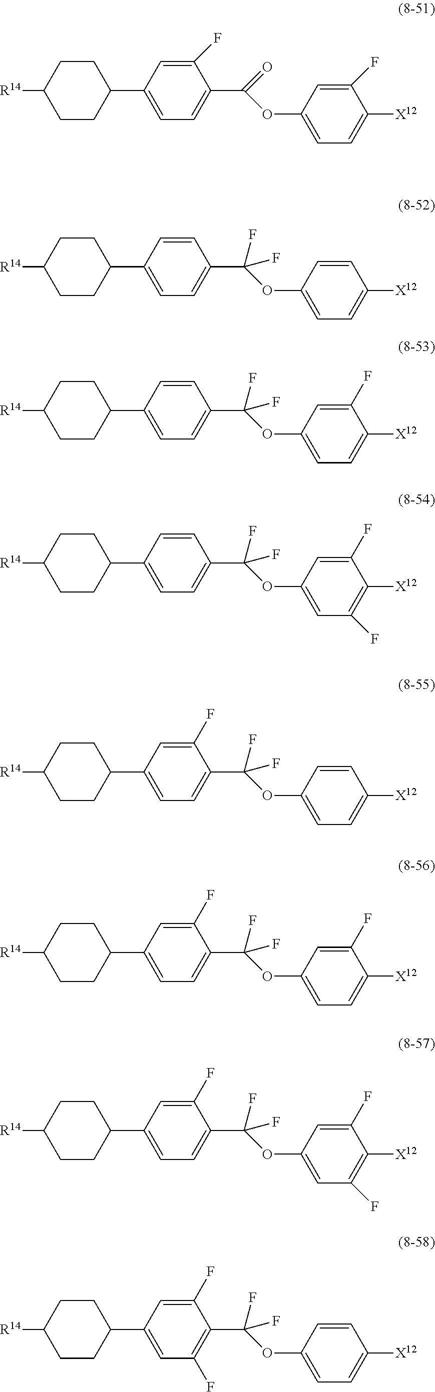

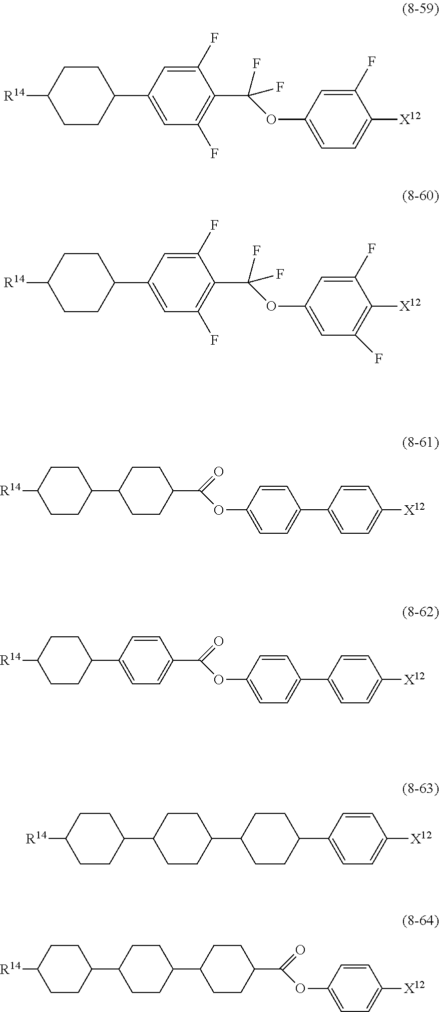

Component D has positive dielectric anisotropy and a value thereof is large, and therefore is mainly used when a composition for a TN mode or the like is prepared. Addition of component D can increase the dielectric anisotropy of the composition. Component D is effective in extending the temperature range of the liquid crystal phase, adjusting the viscosity or adjusting the optical anisotropy. Component D is also useful for adjustment of the voltage-transmittance curve of the device.

When the composition for the TN mode or the like is prepared, a content of component D is suitably in the range of 1% by weight to 99% by weight, preferably in the range of 10% by weight to 97% by weight, and further preferably in the range of 40% by weight to 95% by weight, based on the weight of the liquid crystal composition. When component D is added to a composition having negative dielectric anisotropy, the content of component D is preferably 30% by weight or less based on the weight of the liquid crystal composition. Addition of component D allows adjustment of the elastic constant of the composition and adjustment of the voltage-transmittance curve of the device.

Component E includes compounds (9) to (15). The compounds have phenylene in which hydrogen in lateral positions are replaced by two halogens, such as 2,3-difluoro-1,4-phenylene. Preferred examples of component E include compounds (9-1) to (9-8), compounds (10-1) to (10-17), compound (11-1), compounds (12-1) to (12-3), compounds (13-1) to (13-11), compounds (14-1) to (14-3) and compounds (15-1) to (15-3). In a compound of component E, R¹⁵ and R¹⁶ are independently alkyl having 1 to 10 carbons or alkenyl having 2 to 10 carbons, and in the alkyl and the alkenyl, at least one —CH₂— may be replaced by —O—, and at least one hydrogen may be replaced by fluorine; and R¹⁷ is hydrogen, fluorine, alkyl having 1 to 10 carbons or alkenyl having 2 to 10 carbons, and in the alkyl and the alkenyl, at least one —CH₂— may be replaced by —O—, and at least one hydrogen may be replaced by fluorine.

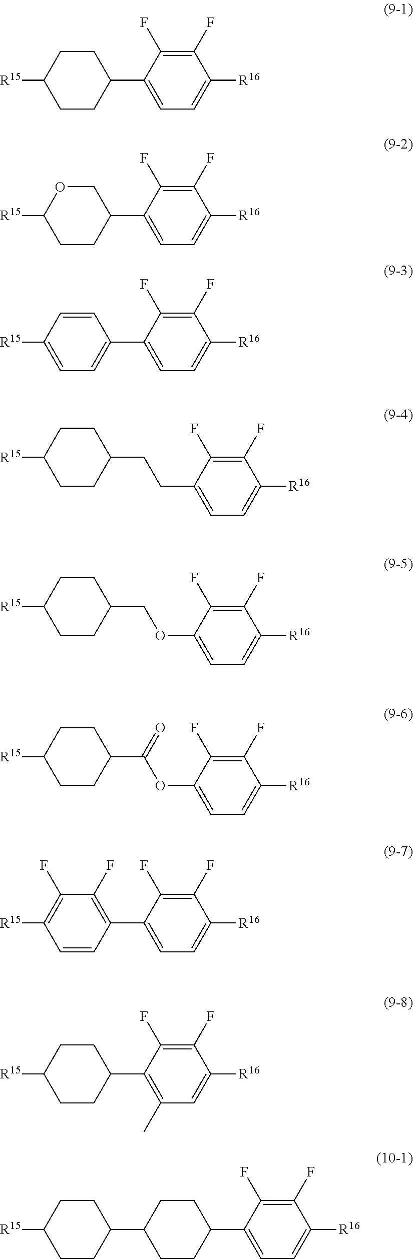

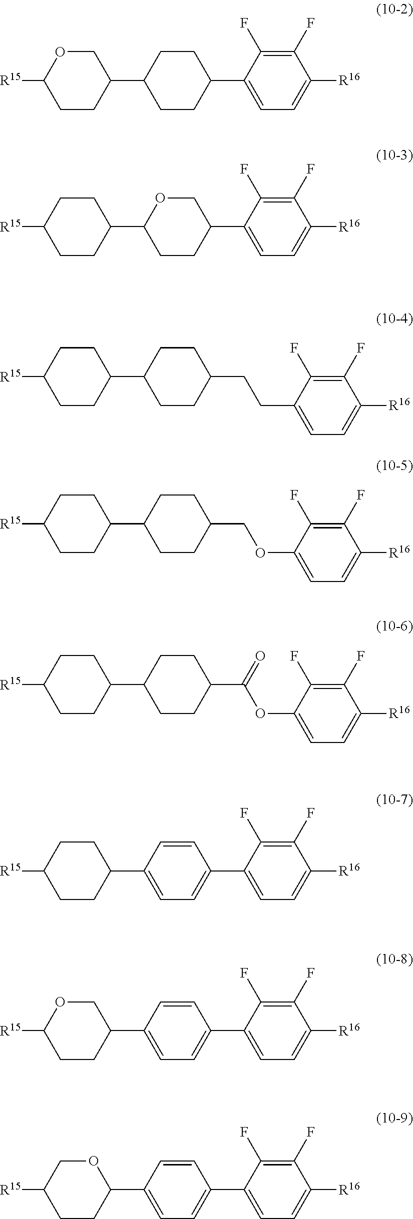

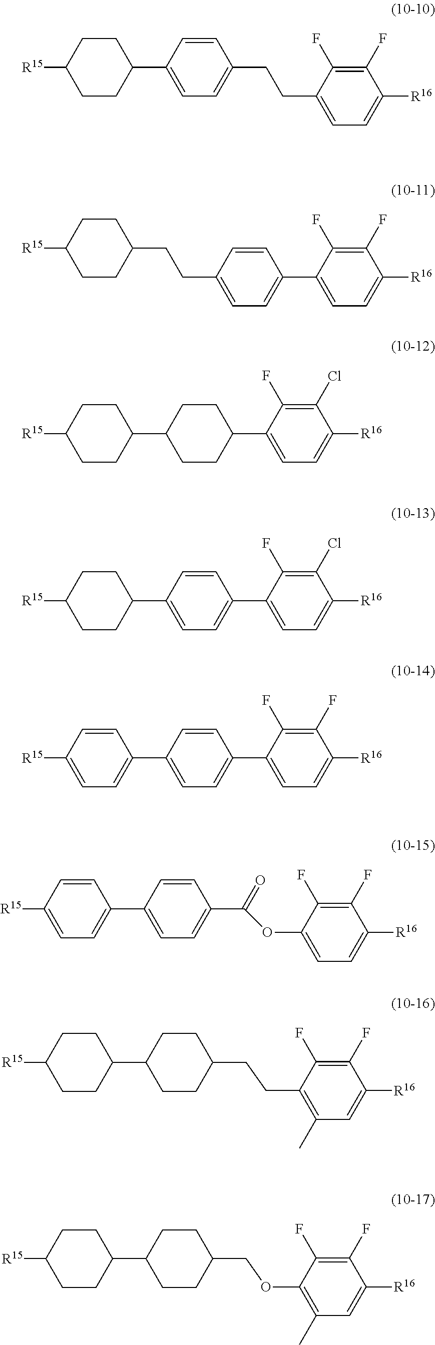

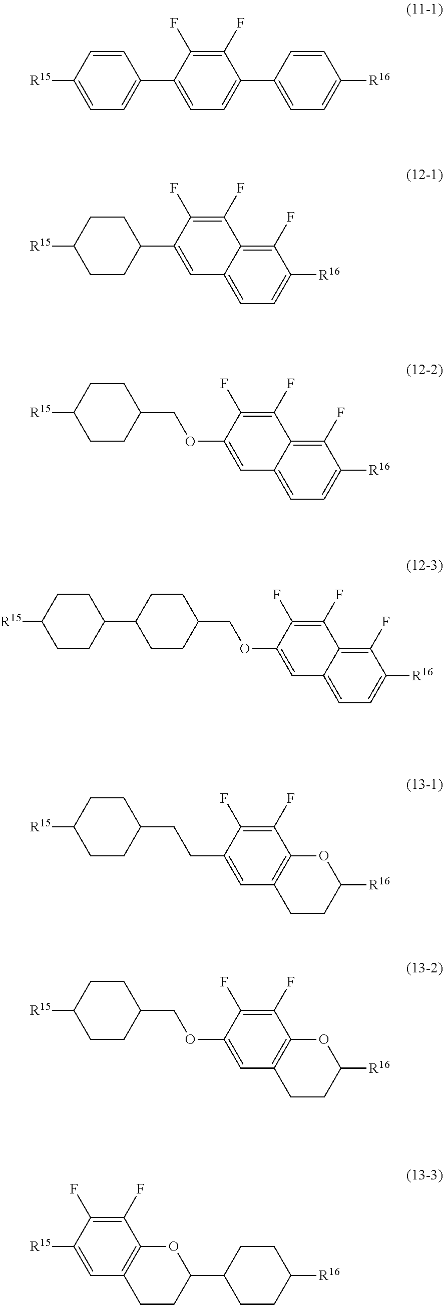

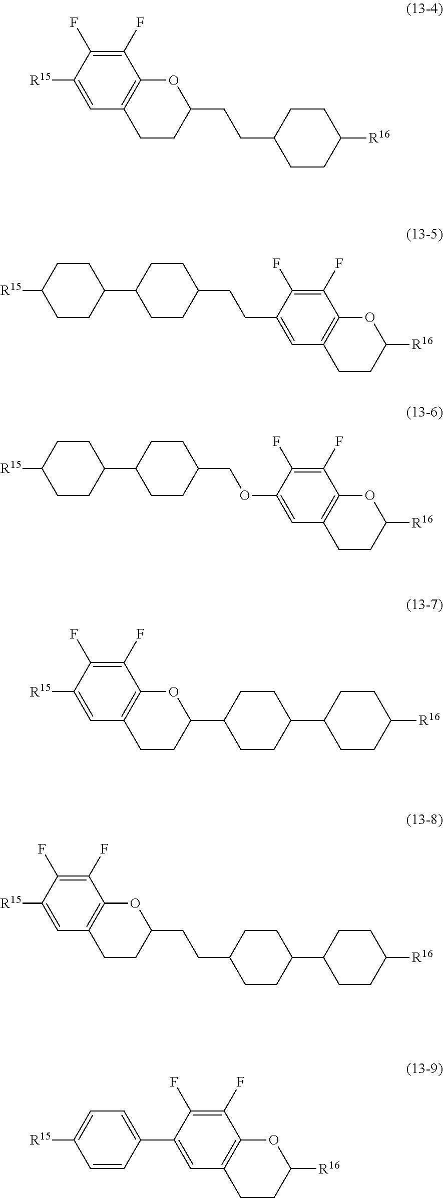

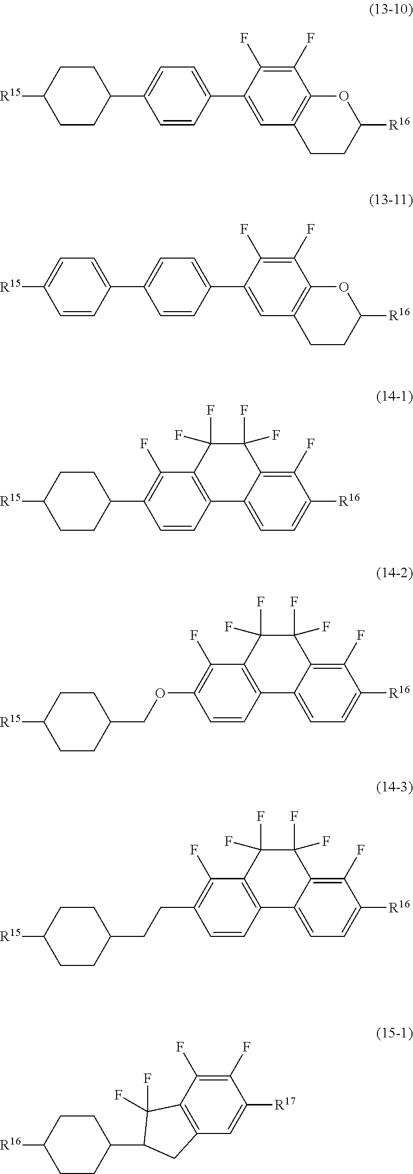

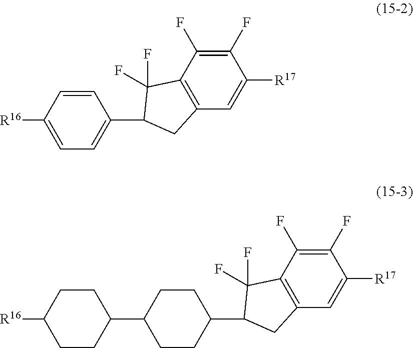

Component E has large negative dielectric anisotropy. Component E is used when a composition for the IPS mode, the VA mode, a PSA mode or the like is prepared. As a content of component E is increased, the dielectric anisotropy of the composition is negatively increased, but the viscosity is increased. Thus, as long as a desired value of threshold voltage of the device is met, the content is preferably as small as possible. When considering the dielectric anisotropy at a degree of −5, the content is preferably 40% by weight or more in order to allow a sufficient voltage driving.

Among types of component E, compound (9) is a bicyclic compound, and therefore is mainly effective in decreasing the viscosity, adjusting the optical anisotropy or increasing the dielectric anisotropy. Compounds (10) and (11) are a tricyclic compound, and therefore are effective in increasing the maximum temperature, the optical anisotropy or the dielectric anisotropy. Compounds (12) to (15) are effective in increasing the dielectric anisotropy.

When a composition for the IPS mode, the VA mode, the PSA mode or the like is prepared, the content of component E is preferably 40% by weight or more, and further preferably in the range of 50% by weight to 95% by weight, based on the weight of the liquid crystal composition. When component E is added to a composition having positive dielectric anisotropy, the content of component E is preferably 30% by weight or less based on the weight of the liquid crystal composition. Addition of component E allows adjustment of the elastic constant of the composition and adjustment of the voltage-transmittance curve of the device.

The liquid crystal composition satisfying at least one of characteristics such as high maximum temperature, low minimum temperature, small viscosity, suitable optical anisotropy, large positive or negative dielectric anisotropy, large specific resistance, high stability to ultraviolet light, high stability to heat and a large elastic constant can be prepared by suitably combining components B, C, D and E described above. Any other liquid crystal compound different from components B, C, D and E may be added thereto when necessary.

The liquid crystal composition is prepared according to a publicly-known method. For example, the component compounds are mixed and dissolved in each other by heating. According to an application, an additive may be added to the composition. Specific examples of the additives include the polymerizable compound other than formula (1) and formula (16), the polymerization initiator, the polymerization inhibitor, the optically active compound, the antioxidant, the ultraviolet light absorber, a light stabilizer, a heat stabilizer and the antifoaming agent. Such additives are well known to those skilled in the art, and described in literature.

The polymerizable compound other than formula (16) or formula (16) is added for the purpose of forming the polymer in the liquid crystal composition. The polymerizable compound and compound (1) are copolymerized by irradiation with ultraviolet light while voltage is applied between electrodes, and thus the polymer is formed in the liquid crystal composition. On the occasion, compound (1) is fixed in a state in which the polar group noncovalently interacts with a substrate surface. Thus, capability of controlling alignment of liquid crystal molecules is further improved, and at the same time, the polar compound no longer leaks into the liquid crystal composition. Moreover, suitable pretilt can be obtained even in the substrate surface, and therefore a liquid crystal display device in which a response time is shortened and the voltage holding ratio is large can be obtained. Specific examples of a preferred polymerizable compound include acrylate, methacrylate, a vinyl compound, a vinyloxy compound, propenyl ether, an epoxy compound (oxirane, oxetane) and vinyl ketone. Further preferred examples include a compound having at least one acryloyloxy and a compound having at least one methacryloyloxy. Still further preferred examples also include a compound having both acryloyloxy and methacryloyloxy.

In a composition containing compound (1α), still further preferred examples include compounds (M-1) to (M-17). In compounds (M-1) to (M-17), R²⁵ to R³¹ are independently hydrogen or methyl; s, v and x are independently 0 or 1; t and u are independently an integer from 1 to 10; and L²¹ to L²⁶ are independently hydrogen or fluorine, and L²⁷ and L²⁸ are independently hydrogen, fluorine or methyl.

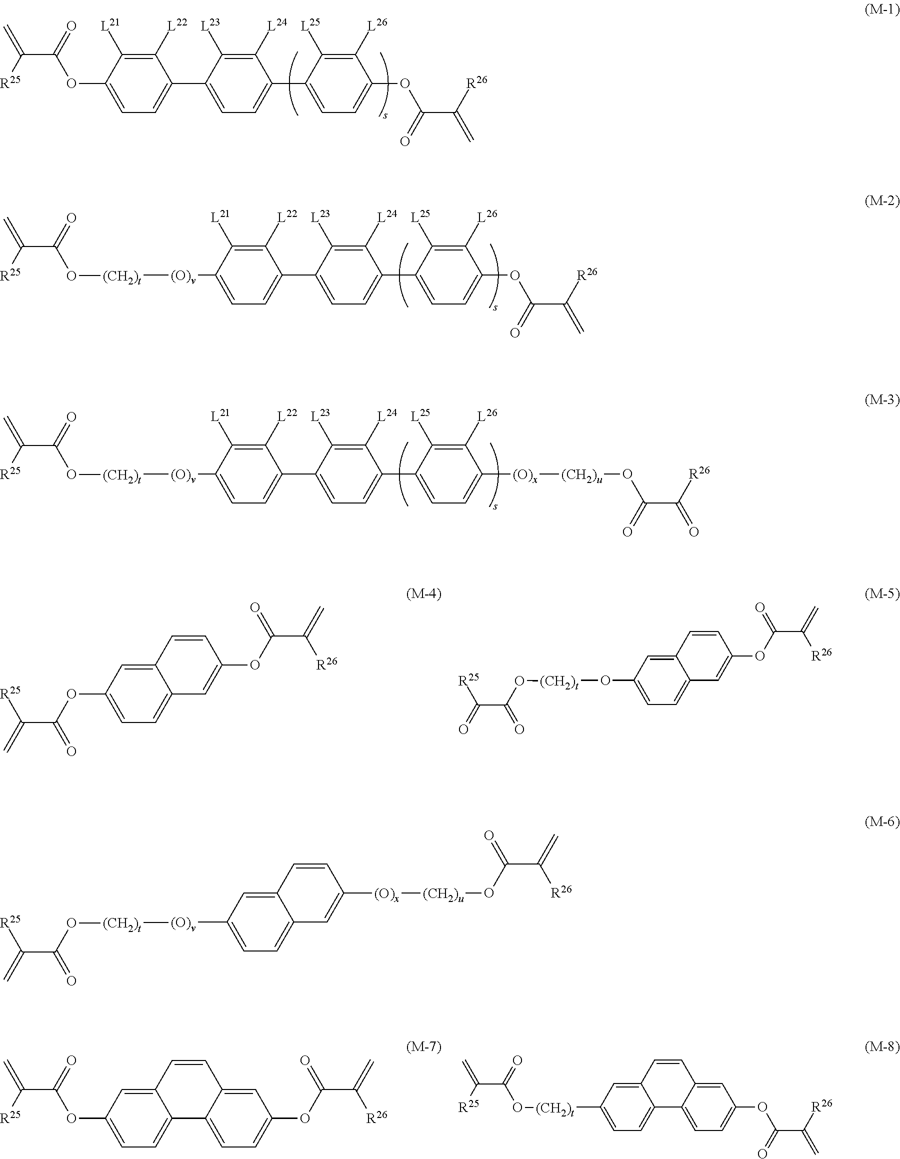

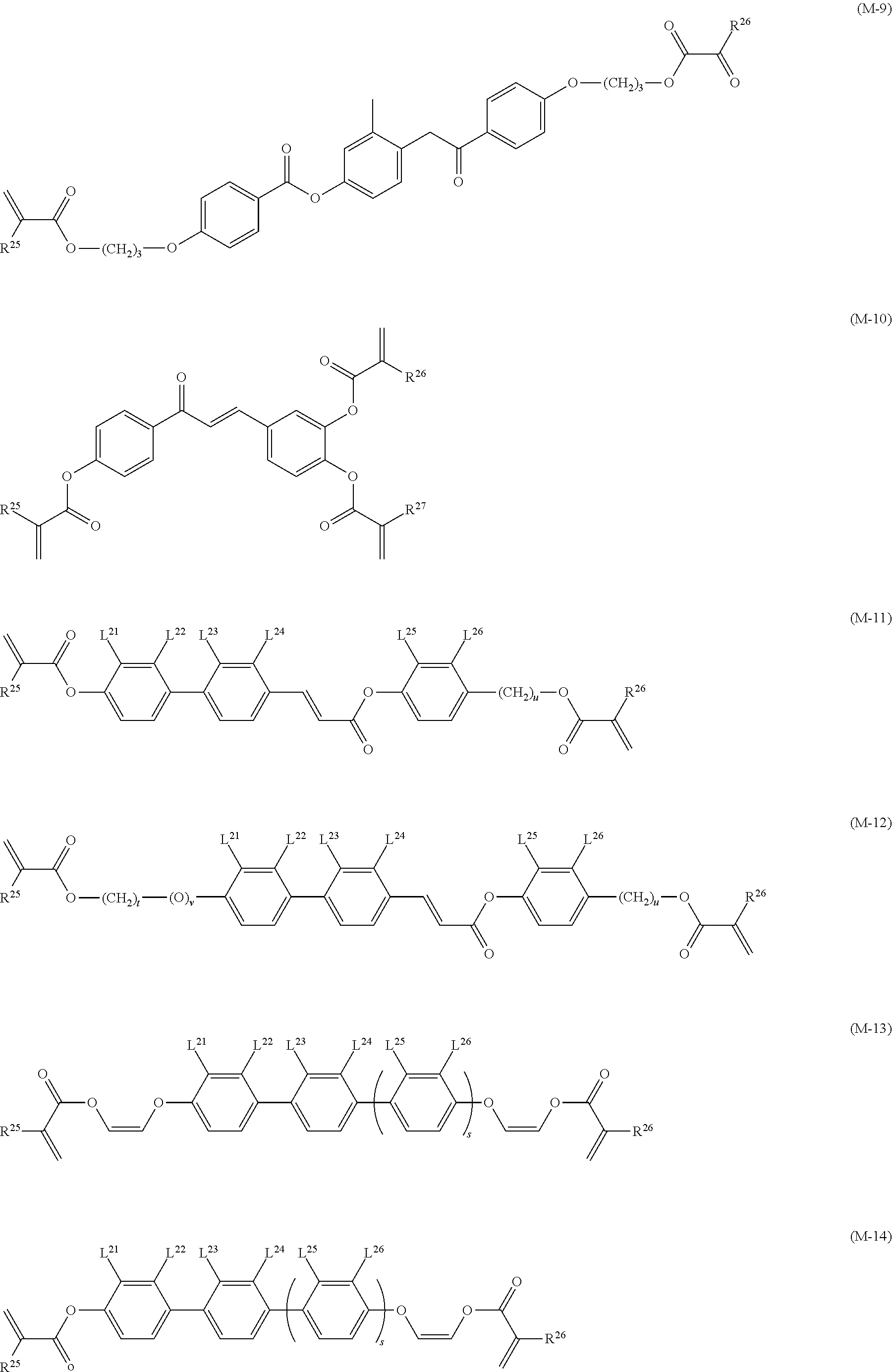

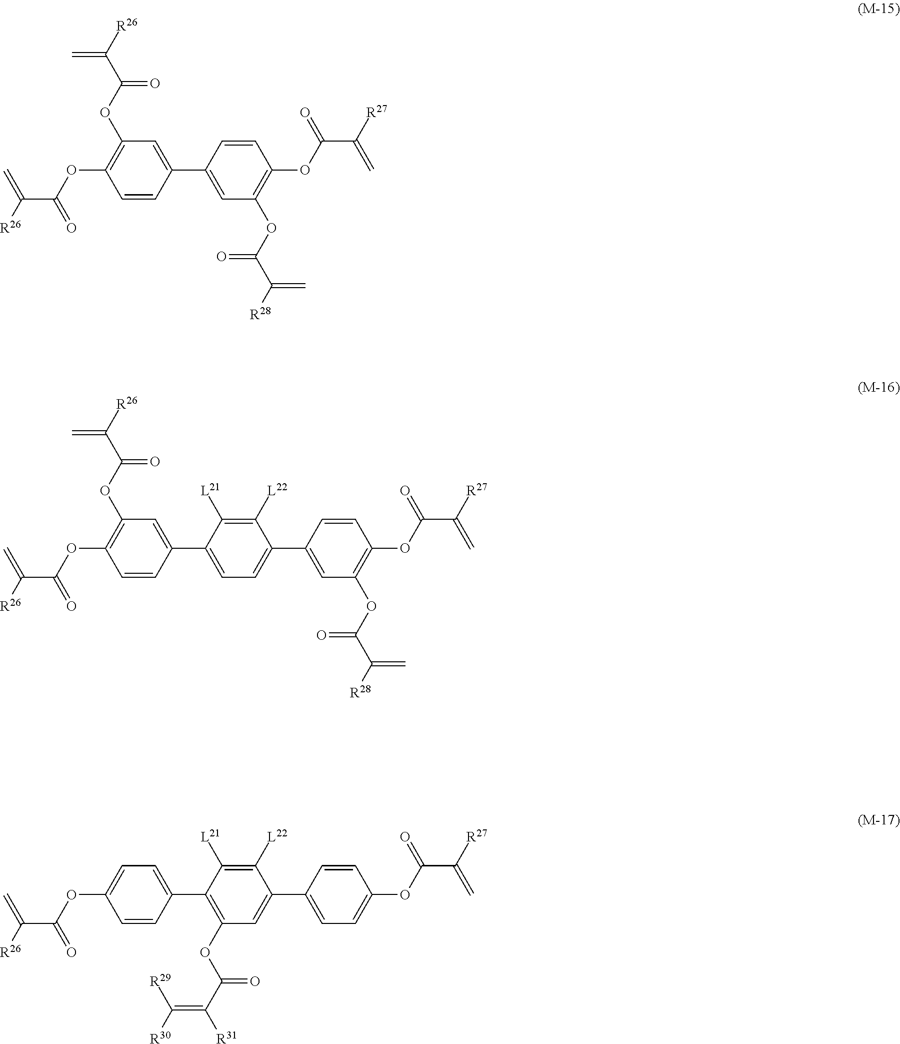

In a composition containing compound (1β) or compound (1γ), still further preferred examples include compounds (16-1-1) to (16-16). In compounds (16-1-1) to (16-16), R²⁵ to R³¹ are independently hydrogen or methyl; v and x are independently 0 or 1; t and u are independently an integer from 1 to 10; and L³¹ to L³⁶ are independently hydrogen or fluorine, and L³⁷ and L³⁸ are independently hydrogen, fluorine or methyl.

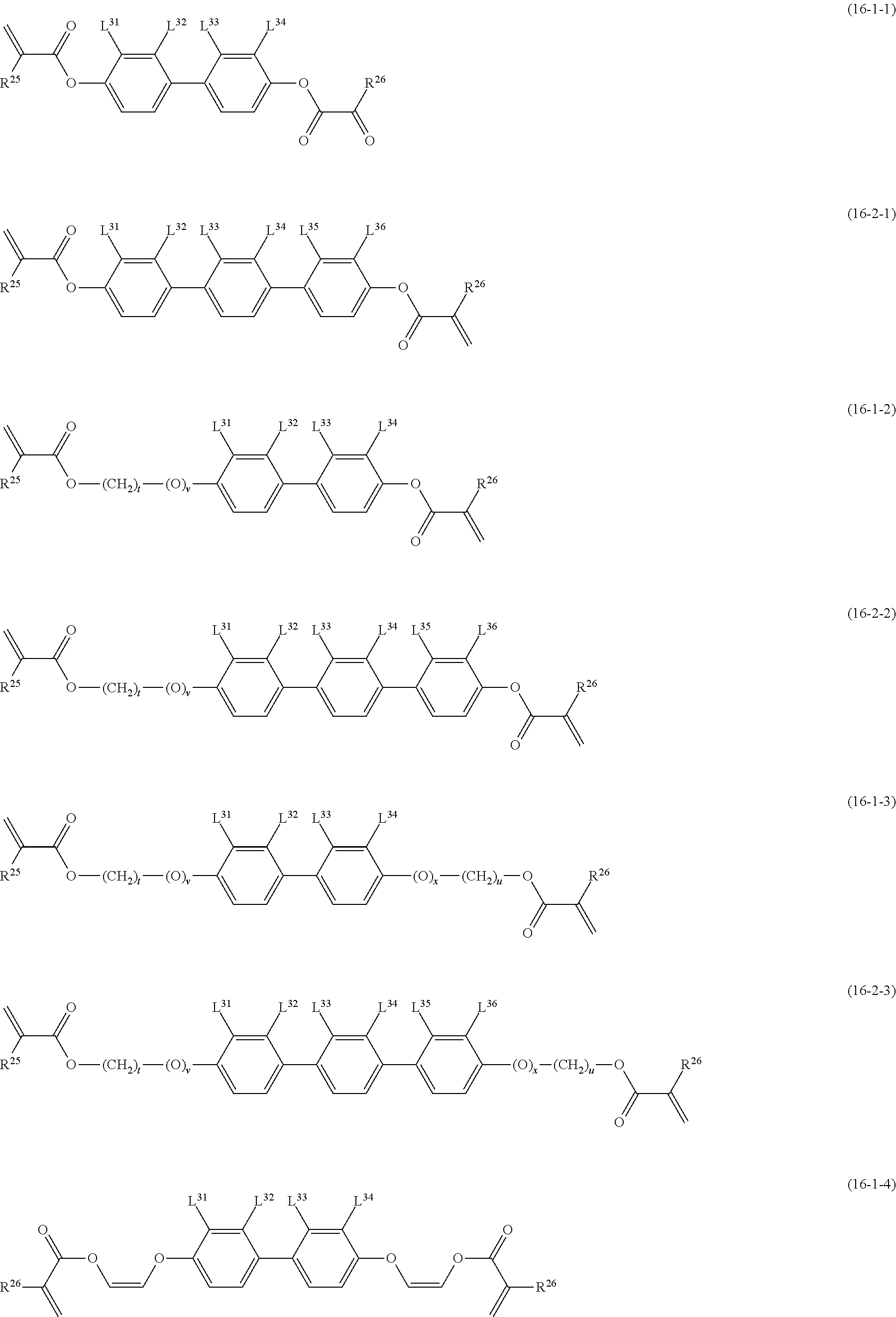

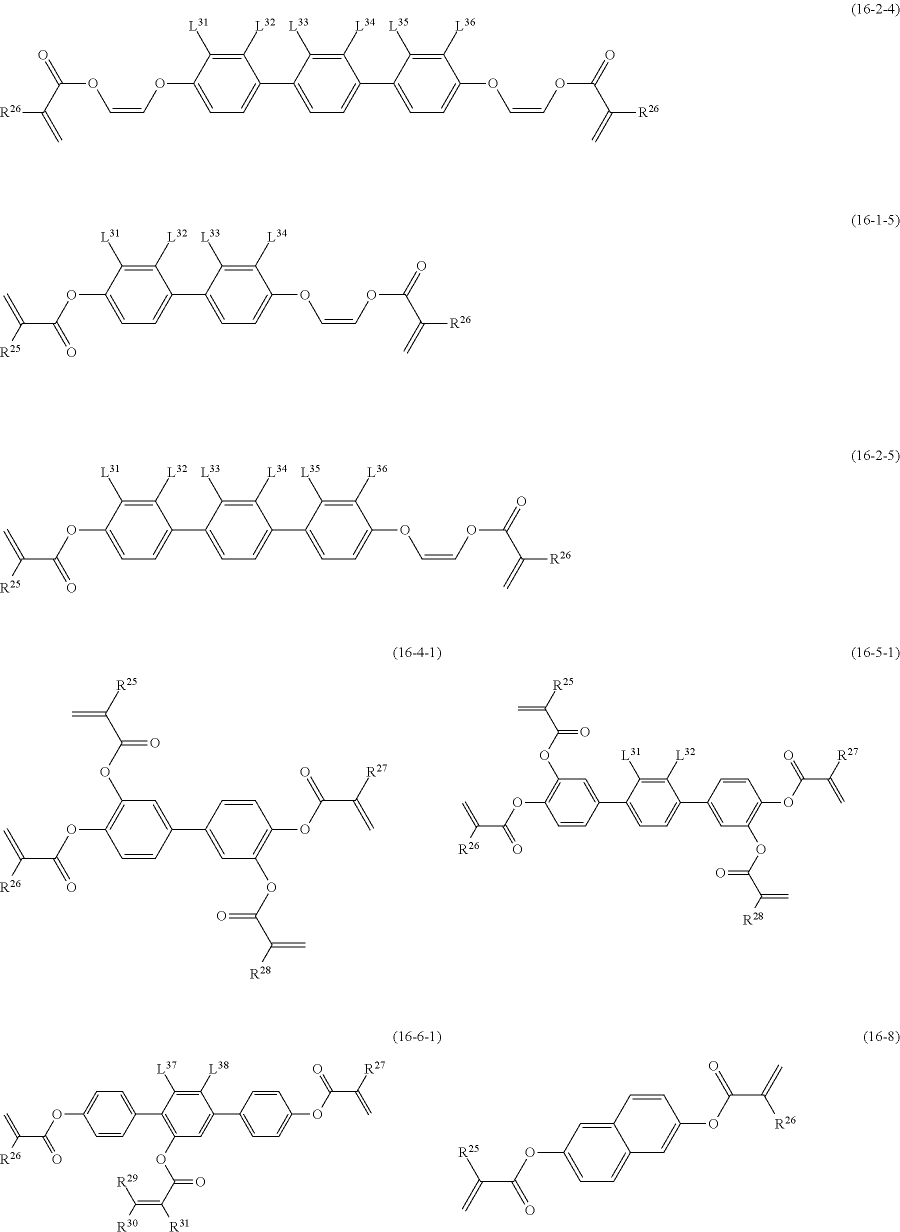

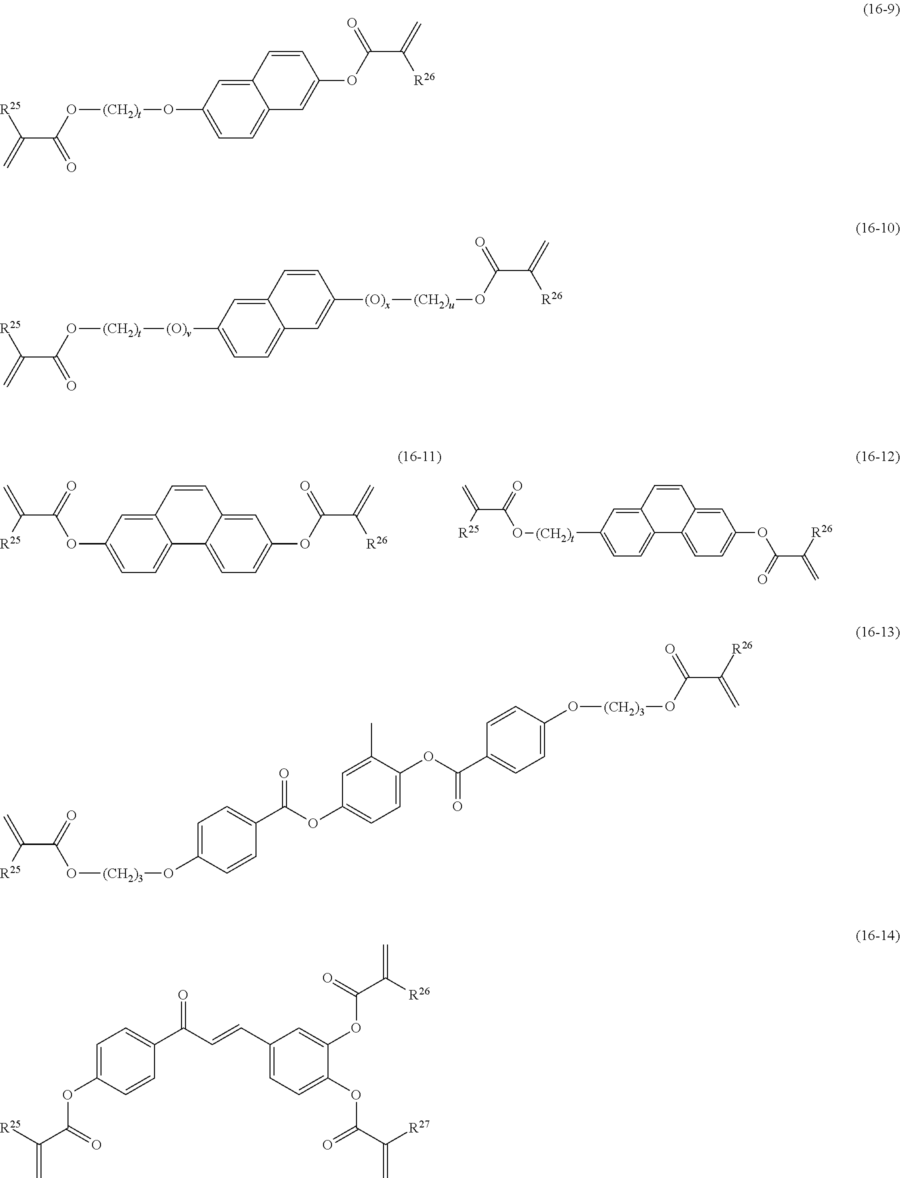

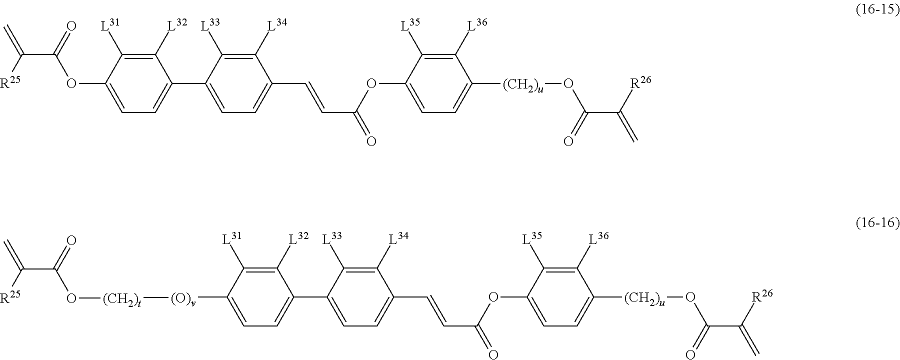

The polymerizable compound can be rapidly polymerized by adding the polymerization initiator. An amount of a remaining polymerizable compound can be decreased by optimizing a reaction temperature. Specific examples of a photoradical polymerization initiator include TPO, 1173 and 4265 from Darocur series of BASF SE, and 184, 369, 500, 651, 784, 819, 907, 1300, 1700, 1800, 1850 and 2959 from Irgacure series thereof.

Additional examples of the photoradical polymerization initiator include 4-methoxyphenyl-2,4-bis(trichloromethyl)triazine, 2-(4-butoxystyryl)-5-trichloromethyl-1,3,4-oxadiazole, 9-phenylacridine, 9,10-benzphenazine, a benzophenone-Michler's ketone mixture, a hexaarylbiimidazole-mercaptobenzimidazole mixture, 1-(4-isopropylphenyl)-2-hydroxy-2-methylpropane-1-one, benzyl dimethyl ketal, 2-methyl-1-[4-(methylthio)phenyl]-2-morpholinopropane-1-one, a mixture of 2,4-diethylxanthone and methyl p-dimethylaminobenzoate, and a mixture of benzophenone and methyltriethanolamine.

After the photoradical polymerization initiator is added to the liquid crystal composition, polymerization can be performed by irradiation with ultraviolet light while an electric field is applied. However, an unreacted polymerization initiator or a decomposition product of the polymerization initiator may cause a poor display such as image persistence in the device. In order to prevent such an event, photopolymerization may be performed with no addition of the polymerization initiator. A preferred wavelength of irradiation light is in the range of 150 nanometers to 500 nanometers. A further preferred wavelength is in the range of 250 nanometers to 450 nanometers, and a most preferred wavelength is in the range of 300 nanometers to 400 nanometers.

Upon storing the polymerizable compound, the polymerization inhibitor may be added thereto for preventing polymerization. The polymerizable compound is ordinarily added to the composition without removing the polymerization inhibitor. Specific examples of the polymerization inhibitor include hydroquinone, a hydroquinone derivative such as methylhydroquinone, 4-t-butylcatechol, 4-methoxyphenol and phenothiazine.

The optically active compound is effective in inducing a helical structure in liquid crystal molecules to give a required twist angle, and thereby preventing a reverse twist. A helical pitch can be adjusted by adding the optically active compound. Two or more optically active compounds may be added for the purpose of adjusting temperature dependence of the helical pitch. Specific examples of a preferred optically active compound include compounds (Op-1) to (Op-18) described below. In compound (Op-18), ring J is 1,4-cyclohexylene or 1,4-phenylene, and R²⁸ is alkyl having 1 to 10 carbons.

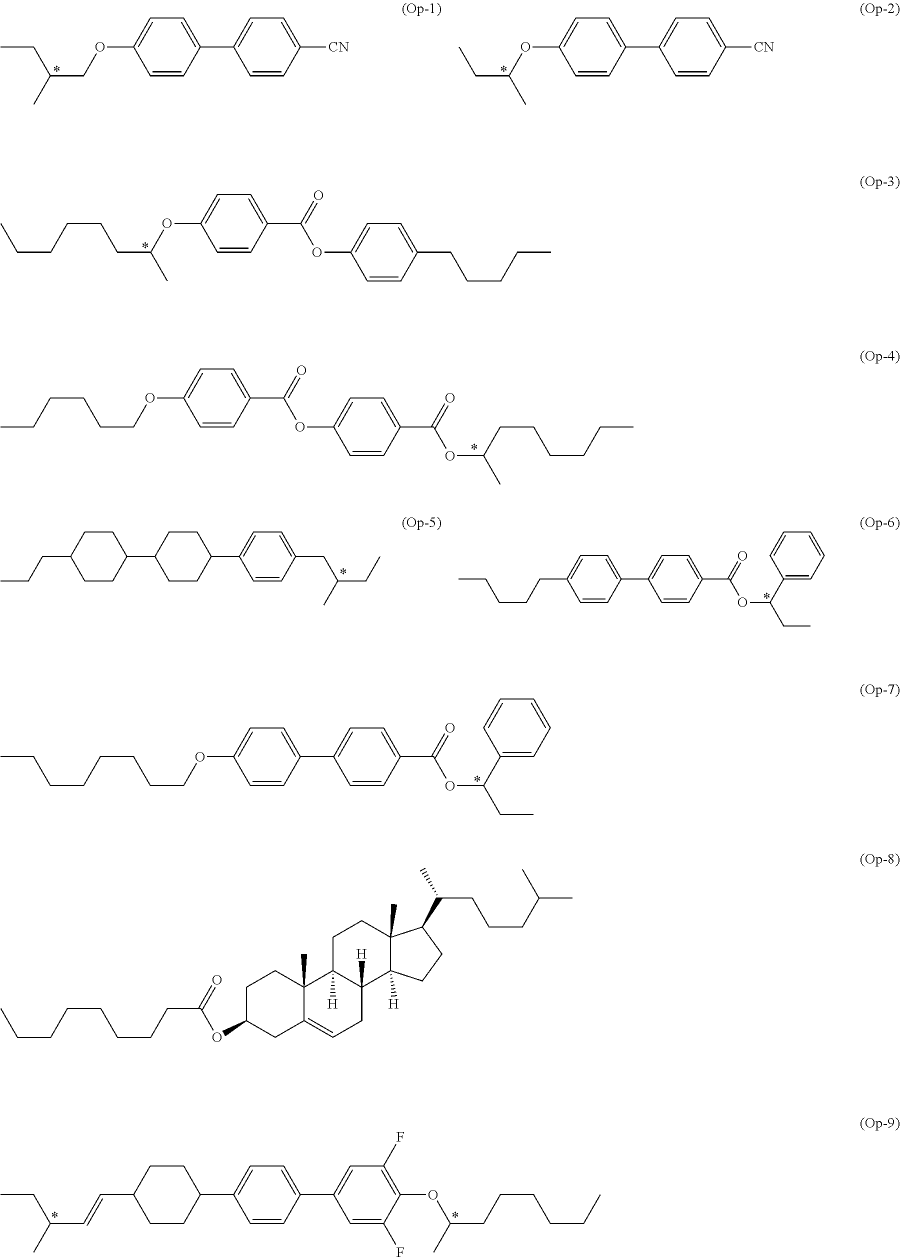

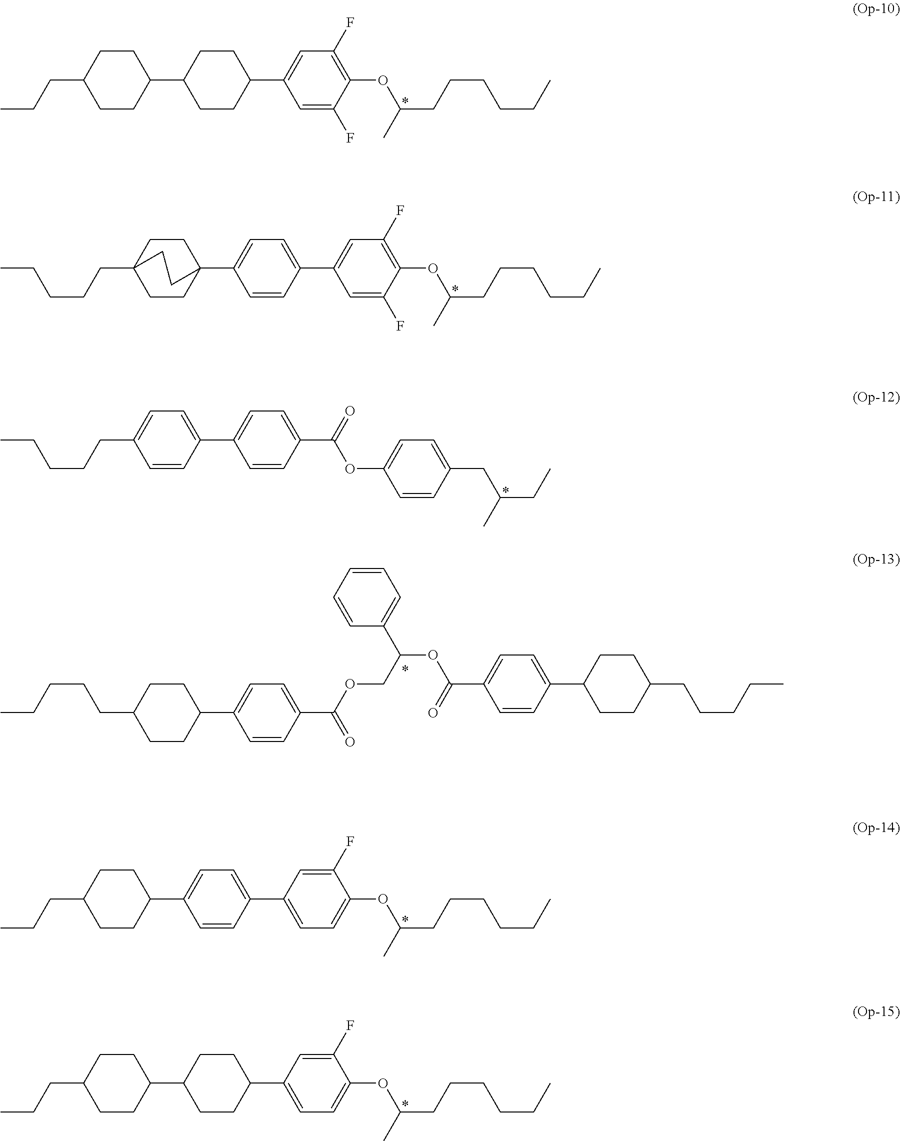

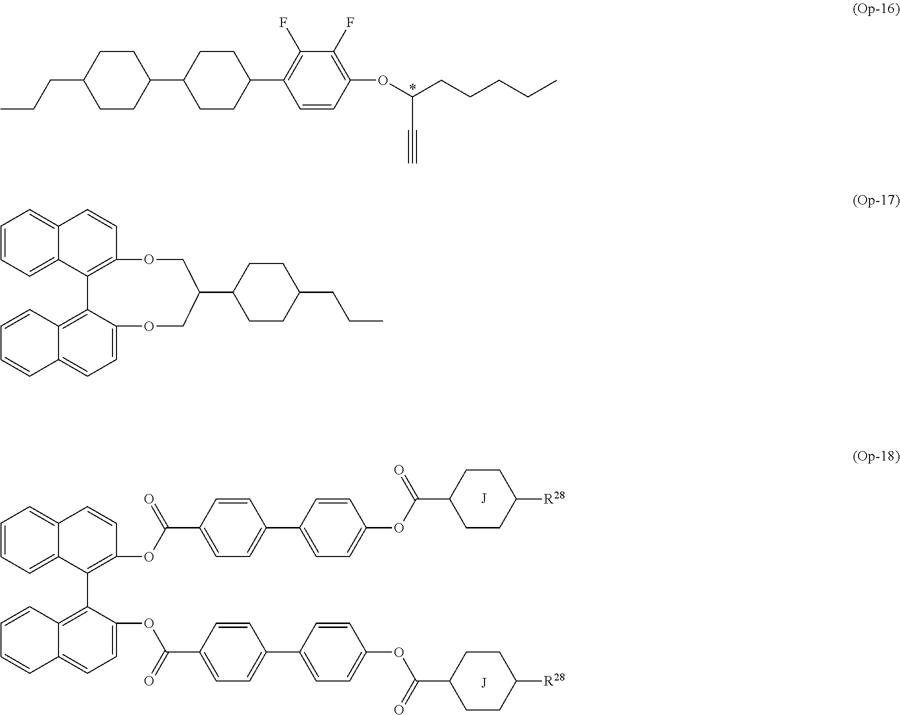

The antioxidant is effective for maintaining the large voltage holding ratio. Specific examples of a preferred antioxidant include compounds (AO-1) and (AO-2); and IRGANOX 415, IRGANOX 565, IRGANOX1010, IRGANOX 1035, IRGANOX 3114 and IRGANOX 1098 (trade names: BASF SE). The ultraviolet light absorber is effective for preventing a decrease of the maximum temperature. Specific examples of a preferred ultraviolet light absorber include a benzophenone derivative, a benzoate derivative and a triazole derivative. Specific examples include compounds (AO-3) and (AO-4); TINUVIN 329, TINUVIN P, TINUVIN 326, TINUVIN 234, TINUVIN 213, TINUVIN 400, TINUVIN 328 and TINUVIN 99-2 (trade names: BASF SE); and 1,4-diazabicyclo[2.2.2]octane (DABCO).

The light stabilizer such as an amine having steric hindrance is preferred for maintaining the large voltage holding ratio. Specific examples of a preferred light stabilizer include compounds (AO-5) and (AO-6); and TINUVIN 144, TINUVIN 765 and TINUVIN 770DF (trade names: BASF SE). The heat stabilizer is also effective for maintaining the large voltage holding ratio, and preferred examples include IRGAFOS 168 (trade name: BASF SE). The antifoaming agent is effective for preventing foam formation. Specific examples of a preferred antifoaming agent include dimethyl silicone oil and methylphenyl silicone oil.

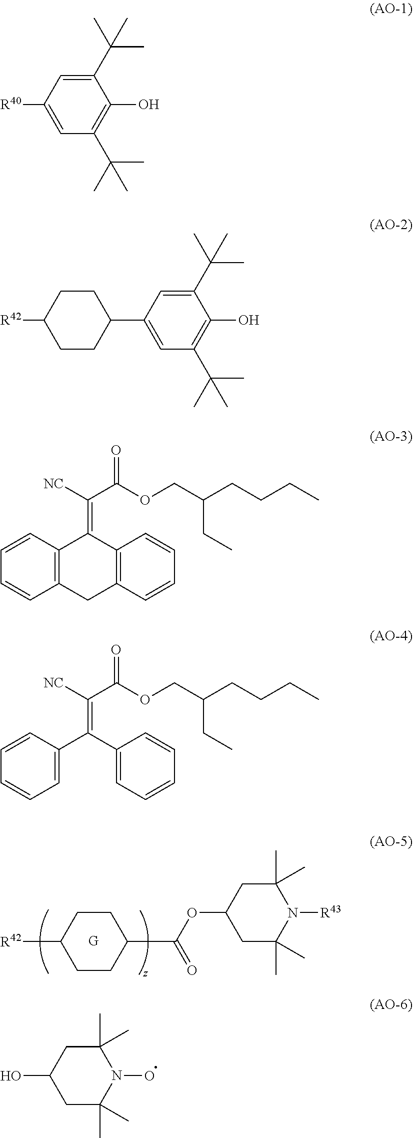

In compound (AO-1), R⁴⁰ is alkyl having 1 to 20 carbons, alkoxy having 1 to 20 carbons, —COOR⁴¹ or —CH₂CH₂COOR⁴¹, in which R⁴¹ is alkyl having 1 to 20 carbons. In compounds (AO-2) and (AO-5), R⁴² is alkyl having 1 to 20 carbons. In compound (AO-5), R⁴³ is hydrogen, methyl or O. (oxygen radical), ring G is 1,4-cyclohexylene or 1,4-phenylene, and z is 1, 2 or 3.

### 17. Liquid Crystal Display Device

The liquid crystal composition can be used in a liquid crystal display device having an operating mode such as a PC mode, the TN mode, an STN mode, the OCB mode and the PSA mode, and driven by an active matrix mode. The composition can also be used in a liquid crystal display device having an operating mode such as the PC mode, the TN mode, the STN mode, the OCB mode, the VA mode and the IPS mode, and driven by a passive matrix mode. The devices can be applied to any of a reflective type, a transmissive type and a transflective type.

The composition can also be used in a nematic curvilinear aligned phase (NCAP) device prepared by microencapsulating a nematic liquid crystal, and a polymer dispersed liquid crystal display device (PDLCD) and a polymer network liquid crystal display device (PNLCD) in which a three-dimensional network-polymer is formed in the liquid crystal. When an amount of adding the polymerizable compound (total amount of compound (1), compound (16) and polymerizable compounds other than the compounds) is about 10% by weight or less based on the weight of the liquid crystal composition, the liquid crystal display device having the PSA mode can be prepared. A preferred proportion is in the range of about 0.1% by weight to about 2% by weight. A further preferred proportion is in the range of about 0.2% by weight to about 1.0% by weight. The device having the PSA mode can be driven by the driving mode such as the active matrix mode and the passive matrix mode. Such a device can also be applied to any of the reflective type, the transmissive type and the transflective type. A device having a polymer dispersed mode can also be prepared by increasing the amount of adding the polymerizable compound.

In the polymer sustained alignment mode device, the polymer contained in the composition aligns liquid crystal molecules. The polar compound helps alignment of liquid crystal molecules. More specifically, the polar compound can be used in place of an alignment film. One example of a method for producing such a device is as described below. The device having two substrates referred to as an array substrate and a color filter substrate is prepared. The substrates have no alignment film. At least one of the substrates has an electrode layer. A liquid crystal compound is mixed to prepare a liquid crystal composition. The polymerizable compound and the polar compound are added to the composition. An additive may be further added thereto when necessary. The composition is injected into the device. The device is irradiated with light while voltage is applied to the device. Ultraviolet light is preferred. The polymerizable compound is polymerized by irradiation with light. A composition containing the polymer is formed by the polymerization, and a device having the PSA mode is prepared.

In the above procedure, the polar group interacts with the substrate surface, and therefore the polar compound is aligned on a substrate. The polar compound aligns liquid crystal molecules. When voltage is applied, the alignment of the liquid crystal molecules is further promoted by action of an electric field. The polymerizable compound is also aligned according to the alignment. The polymerizable compound is polymerized by ultraviolet light in the above state, and therefore a polymer maintaining the alignment is formed. The alignment of the liquid crystal molecules is additionally stable by an effect of the polymer, and therefore the response time of the device is shortened. The image persistence is caused due to poor operation in the liquid crystal molecules, and therefore the persistence is also simultaneously improved by the effect of the polymer. In particular, compound (1) used in the invention is a polymerizable polar compound, and therefore aligns liquid crystal molecules, and is subjected to homopolymerization or copolymerized with a reactive monomer as any other polymerizable compound. Thus, in the invention, the polar compound no longer leaks into the liquid crystal composition, and therefore the liquid crystal display device in which the voltage holding ratio is large can be obtained.

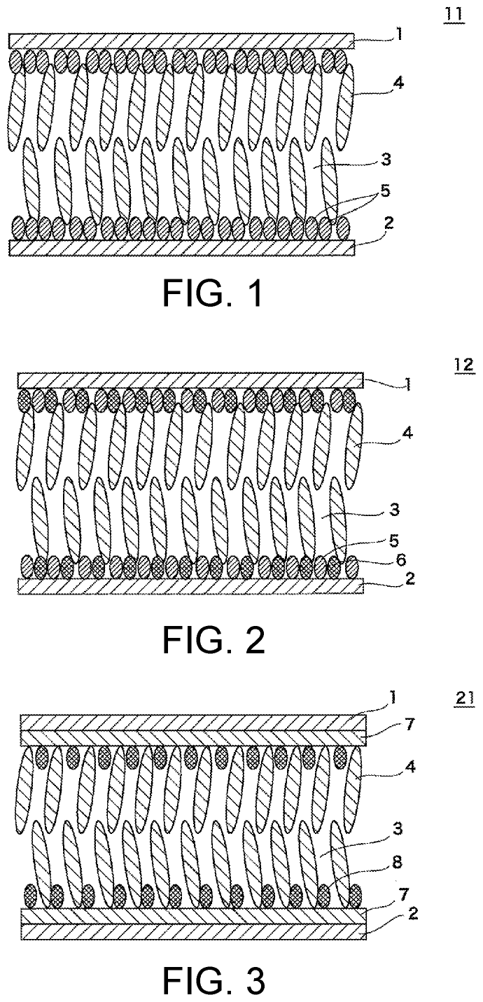

FIG. 1 shows device 11 in a state in which compound (1) that functions as alignable monomer 5 is arranged on color filter substrate 1 and array substrate 2 by interaction of a polar group with a substrate surface. An alignment control layer is formed by polymerization of compound (1). FIG. 2 shows device 12 in a state in which compound (1) that functions as alignable monomer 5 is arranged on color filter substrate 1 and array substrate 2 by interaction of a polar group with a substrate surface. The alignment control layer is formed by copolymerization of compound (1) with compound (16) that functions as reactive monomer 6. FIG. 3 is a schematic view of device 21 having a conventional alignment film and including the polymerizable compound.

In addition, the liquid crystal display device of the invention is not limited to the device with a structure having two substrates such as array substrate 2 and color filter substrate 1 as shown in FIG. 1 to FIG. 2, and for example, may be a device with a color filter on array (COA) structure having a color filter (CF) formed on a TFT substrate, or understandably may be a device with a structure other than above.

Compound (1) aligned on the substrate is polymerized by irradiation with ultraviolet light to form the alignment control layer on each substrate. Thickness of one layer (only one side) of the alignment control layer is 10 to 100 nanometers, preferably 10 to 80 nanometers, and further preferably 20 to 80 nanometers. If the thickness is 10 nanometers or more, electric characteristics can be maintained, and therefore such a case is preferred. If the thickness is 100 nanometers or less, driving voltage can be suitably decreased, and therefore such a case is preferred.

Thus, the liquid crystal display device of the application can form the alignment control layer, and therefore the liquid crystal compounds are vertically aligned to a substrate surface. Then, an angle (more specifically, pretilt angle) of the liquid crystal compound to the substrate surface is 90±10 degrees, preferably 90±5 degrees, and further preferably 90±3 degrees. If the angle is 90±10 degrees, such a case is preferred from a viewpoint of optical characteristics.

If the pretilt angle can be given to the liquid crystal compound by using the alignment control layer, combination with pixel electrodes having a slit and subjected to pixel division can achieve a wide viewing angle by the pixel division.

In a vertical alignment (VA) mode liquid crystal display device as one embodiment of the invention, a direction of alignment of liquid crystal molecules during no voltage application is substantially vertically aligned relative to the substrate surface. In order to vertically align the liquid crystal molecules, as shown in FIG. 3, vertical alignment films such as a polyimide alignment film, a polyamide alignment film and a polysiloxane alignment film are ordinarily each arranged between color filter substrate 1 and liquid crystal layer 3 and between array substrate 2 and liquid crystal layer 3, but the liquid crystal display device of the invention does not require such an alignment film.

### EXAMPLES

The invention will be described in greater detail by way of Examples (including Synthesis Examples). However, the invention is not limited by the Examples. The invention includes a mixture of composition (i) and composition (ii). The invention also includes a mixture prepared by mixing at least two of the compositions.

### 1. Measuring Method

Unless otherwise specified, reaction was performed under a nitrogen atmosphere. Compound (1) was prepared according to procedures shown in Synthesis Examples and so forth. The thus prepared compound was identified by a method such as an NMR analysis. Characteristics of compound (1), a liquid crystal compound, a composition and a device were measured by methods described below.

NMR analysis: For measurement, DRX-500 made by Bruker BioSpin Corporation was used. In ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, CFCl₃ was used as an internal standard, and measurement was carried out under conditions of 24 times of accumulation. In explaining nuclear magnetic resonance spectra obtained, s, d, t, g, quin, sex and m stand for a singlet, a doublet, a triplet, a quartet, a quintet, a sextet and a multiplet, and br being broad, respectively.

Gas chromatographic analysis: For measurement, GC-2010 Gas Chromatograph made by Shimadzu Corporation was used. As a column, a capillary column DB-1 (length 60 m, bore 0.25 mm, film thickness 0.25 μm) made by Agilent Technologies, Inc. was used. As a carrier gas, helium (1 mL/minute) was used. A temperature of a sample vaporizing chamber and a temperature of a detector (FID) part were set to 300° C. and 300° C., respectively. A sample was dissolved in acetone and prepared to be a 1 weight % solution, and then 1 microliter of the solution obtained was injected into the sample vaporizing chamber. As a recorder, GC Solution System made by Shimadzu Corporation or the like was used.

HPLC analysis: For measurement, Prominence (LC-20AD; SPD-20A) made by Shimadzu Corporation was used. As a column, YMC-Pack ODS-A (length 150 mm, bore 4.6 mm, particle diameter 5 μm) made by YMC Co., Ltd. was used. As an eluate, acetonitrile and water were appropriately mixed and used. As a detector, a UV detector, an RI detector, a CORONA detector or the like was appropriately used. When the UV detector was used, a detection wavelength was set at 254 nanometers. A sample was dissolved in acetonitrile and prepared to be a 0.1 weight % solution, and then 1 microliter of the solution was injected into a sample chamber. As a recorder, C-R7Aplus made by Shimadzu Corporation was used.

Ultraviolet-visible spectrophotometry: For measurement, PharmaSpec UV-1700 made by Shimadzu Corporation was used. A detection wavelength was adjusted in the range of 190 nanometers to 700 nanometers. A sample was dissolved in acetonitrile and prepared to be a 0.01 mmol/L solution, and measurement was carried out by putting the solution in a quartz cell (optical path length: 1 cm).

Sample for measurement: Upon measuring phase structure and a transition temperature (a clearing point, a melting point, a polymerization starting temperature or the like), a compound itself was used as a sample.

Measuring method: Characteristics were measured according to methods described below. Most of the measuring methods are applied as described in the Standard of Japan Electronics and Information Technology Industries Association (hereinafter abbreviated as JEITA) (JEITA ED-2521B) discussed and established by JEITA, or modified thereon. No thin film transistor (TFT) was attached to a TN device used for measurement.

### (1) Phase Structure

A sample was placed on a hot plate in a melting point apparatus (FP-52 Hot Stage made by Mettler-Toledo International Inc.) equipped with a polarizing microscope. A state of phase and a change thereof were observed with the polarizing microscope while the sample was heated at a rate of 3° C. per minute, and a kind of the phase was specified.

### (2) Transition Temperature (° C.)

For measurement, a scanning calorimeter, Diamond DSC System, made by PerkinElmer, Inc., or a high sensitivity differential scanning calorimeter, X-DSC7000, made by SII NanoTechnology Inc. was used. A sample was heated and then cooled at a rate of 3° C. per minute, and a starting point of an endothermic peak or an exothermic peak caused by a phase change of the sample was determined by extrapolation, and thus a transition temperature was determined. A melting point and a polymerization starting temperature of a compound were also measured using the apparatus. Temperature at which a compound undergoes transition from a solid to a liquid crystal phase such as the smectic phase and the nematic phase may be occasionally abbreviated as “minimum temperature of the liquid crystal phase.” Temperature at which the compound undergoes transition from the liquid crystal phase to liquid may be occasionally abbreviated as “clearing point.”

A crystal was expressed as C. When kinds of the crystals were distinguishable, each of the crystals was expressed as C₁ or C₂. The smectic phase or the nematic phase was expressed as S or N. When smectic A phase, smectic B phase, smectic C phase or smectic F phase was distinguishable among the smectic phases, the phases were expressed as S_{A}, S_{B}, S_{C} or S_{F}, respectively. A liquid (isotropic) was expressed as I. A transition temperature was expressed as “C 50.0 N 100.0 I,” for example. The expression indicates that a transition temperature from the crystals to the nematic phase is 50.0° C., and a transition temperature from the nematic phase to the liquid is 100.0° C.

### (3) Maximum Temperature of Nematic Phase (T_{NI} or NI; ° C.)

A sample was placed on a hot plate in a melting point apparatus equipped with a polarizing microscope and heated at a rate of 1° C. per minute. Temperature when part of the sample began to change from the nematic phase to an isotropic liquid was measured. A maximum temperature of the nematic phase may be occasionally abbreviated as “maximum temperature.” When the sample was a mixture of compound (1) and the base liquid crystal, the maximum temperature was expressed in terms of a symbol T_{NI}. When the sample was a mixture of compound (1) and a compound such as components B, C and D, the maximum temperature was expressed as a symbol NI.

### (4) Minimum Temperature of Nematic Phase (T_{C}; ° C.)

Samples each having the nematic phase were kept in freezers at temperatures of 0° C., −10° C., −20° C., −30° C. and −40° C. for 10 days, and then liquid crystal phases were observed. For example, when the sample maintained the nematic phase at −20° C. and changed to crystals or the smectic phase at −30° C., T_{C} was expressed as T_{C}≤−20° C. A minimum temperature of the nematic phase may be occasionally abbreviated as “minimum temperature.”

(5) Viscosity (Bulk Viscosity; η; Measured at 20° C.; mPa·s)

For measurement, a cone-plate (E type) rotational viscometer made by Tokyo Keiki Inc. was used.

### (6) Optical Anisotropy (Refractive Index Anisotropy; Measured at 25° C.; Δn)

Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when the direction of polarized light was perpendicular to the direction of rubbing. A value of optical anisotropy (Δn) was calculated from an equation: Δn=n∥−n⊥.

(7) Specific resistance (ρ; measured at 25° C.; Ωcm)

Into a vessel equipped with electrodes, 1.0 milliliter of sample was injected. A direct current voltage (10 V) was applied to the vessel, and a direct current after 10 seconds was measured. Specific resistance was calculated from the following equation: (specific resistance)={(voltage)×(electric capacity of a vessel)}/{(direct current)*(dielectric constant of vacuum)}.

Measurement methods of characteristics in a sample having positive dielectric anisotropy may be occasionally different from measurement methods of characteristics in a sample having negative dielectric anisotropy. Measurement methods of the sample having positive dielectric anisotropy were described in sections (8a) to (12a). Measurement methods of the sample having negative dielectric anisotropy were described in sections (8b) to (12b).

(8a) Viscosity (rotational viscosity; γ1; measured at 25° C.; mPa·s)

Positive dielectric anisotropy: Measurement was carried out according to a method described in M. Imai et al., Molecular Crystals and Liquid Crystals, Vol. 259, 37 (1995). A sample was put in a TN device in which a twist angle was 0 degrees and a distance (cell gap) between two glass substrates was 5 micrometers. Voltage was applied stepwise to the device in the range of 16 V to 19.5 V at an increment of 0.5 V. After a period of 0.2 second with no voltage application, voltage was repeatedly applied under conditions of only one rectangular wave (rectangular pulse; 0.2 second) and no voltage application (2 seconds). A peak current and a peak time of transient current generated by the applied voltage were measured. A value of rotational viscosity was obtained from the measured values and calculation equation (8) described on page 40 of the paper presented by M. Imai et al. A value of dielectric anisotropy required for the calculation was determined using the device by which the rotational viscosity was measured and by a method described below.

(8b) Viscosity (rotational viscosity; γ1; measured at 25° C.; mPa·s)

Negative dielectric anisotropy: Measurement was carried out according to a method described in M. Imai et al., Molecular Crystals and Liquid Crystals, Vol. 259, 37 (1995). A sample was put in a VA device in which a distance (cell gap) between two glass substrates was 20 μm. Voltage was applied stepwise to the device in the range of 39 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of transient current generated by the applied voltage were measured. A value of rotational viscosity was obtained from the measured values and calculation equation (8) described on page 40 of the paper presented by M. Imai et al. In dielectric anisotropy required for the calculation, a value measured according to items of dielectric anisotropy as described below was used.

### (9a) Dielectric Anisotropy (Δε; Measured at 25° C.)

Positive dielectric anisotropy: A sample was put in a TN device in which a distance (cell gap) between two glass substrates was 9 micrometers and a twist angle was 80 degrees. Sine waves (10 V, 1 kHz) were applied to the device, and after 2 seconds, a dielectric constant (ε∥) of liquid crystal molecules in a major axis direction was measured. Sine waves (0.5 V, 1 kHz) were applied to the device, and after 2 seconds, a dielectric constant (ε⊥) of liquid crystal molecules in a minor axis direction was measured. A value of dielectric anisotropy was calculated from an equation: Δε=ε∥−ε⊥.

### (9b) Dielectric Anisotropy (Δε; Measured at 25° C.)

Negative dielectric anisotropy: A value of dielectric anisotropy was calculated from an equation: Δε=ε∥−ε⊥. A dielectric constant (ε∥ and ε⊥) was measured as described below.

(1) Measurement of dielectric constant (ε∥): An ethanol (20 mL) solution of octadecyltriethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5V, 1 kHz) were applied to the device, and after 2 seconds, a dielectric constant (ε∥) of liquid crystal molecules in a major axis direction was measured.

(2) Measurement of dielectric constant (ε⊥): A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (ε⊥) of liquid crystal molecules in a minor axis direction was measured.

### (10a) Elastic Constant (K; Measured at 25° C.; pN)

Positive dielectric anisotropy: For measurement, HP4284A LCR Meter made by Yokogawa-Hewlett-Packard Co. was used. A sample was put in a horizontal alignment device in which a distance (cell gap) between two glass substrates was 20 micrometers. An electric charge of 0 V to 20 V was applied to the device, and electrostatic capacity and applied voltage were measured. The measured values of electrostatic capacity (C) and applied voltage (V) were fitted to equation (2.98) and equation (2.101) on page 75 of “Liquid Crystal Device Handbook” (Ekisho Debaisu Handobukku in Japanese; Nikkan Kogyo Shimbun, Ltd.), and values of K₁₁ and K₃₃ were obtained from equation (2.99). Next, K₂₂ was calculated using the previously determined values of K₁₁ and K₃₃ in equation (3.18) on page 171. Elastic constant K was expressed in terms of a mean value of the thus determined K₁₁, K₂₂ and K₃₃.

(10b) Elastic Constant (K₁₁ and K₃₃; Measured at 25° C.; pN)

Negative dielectric anisotropy: For measurement, Elastic Constant Measurement System Model EC-1 made by TOYO Corporation was used. A sample was put in a vertical alignment device in which a distance (cell gap) between two glass substrates was 20 micrometers. An electric charge of 20 V to 0 V was applied to the device, and electrostatic capacity and applied voltage were measured. The measured values of electrostatic capacity (C) and applied voltage (V) were fitted to equation (2.98) and equation (2.101) on page 75 of “Liquid Crystal Device Handbook” (Ekisho Debaisu Handobukku, in Japanese; Nikkan Kogyo Shimbun, Ltd.), and values of elastic constant were obtained from equation (2.100).

### (11a) Threshold Voltage (Vth; Measured at 25° C.; V)

Positive dielectric anisotropy: For measurement, an LCD5100 luminance meter made by Otsuka Electronics Co., Ltd. was used. A light source was a halogen lamp. A sample was put in a normally white mode TN device in which a distance (cell gap) between two glass substrates was 0.45/Δn (μm) and a twist angle was 80 degrees. A voltage (32 Hz, rectangular waves) to be applied to the device was stepwise increased from 0 V to 10 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of a voltage at 90% transmittance.

### (11b) Threshold Voltage (Vth; Measured at 25° C.; V)

Negative dielectric anisotropy: For measurement, an LCD5100 luminance meter made by Otsuka Electronics Co., Ltd. was used. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of a voltage at 10% transmittance.

### (12a) Response Time (τ; Measured at 25° C.; ms)

Positive dielectric anisotropy: For measurement, an LCD5100 luminance meter made by Otsuka Electronics Co., Ltd. was used. A light source was a halogen lamp. A low-pass filter was set to 5 kHz. A sample was put in a normally white mode TN device in which a distance (cell gap) between two glass substrates was 5.0 micrometers and a twist angle was 80 degrees. A voltage (rectangular waves; 60 Hz, 5 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A rise time (τr; millisecond) was expressed in terms of time required for a change from 90% transmittance to 10% transmittance. A fall time (τf; millisecond) was expressed in terms of time required for a change from 10% transmittance to 90% transmittance. A response time was expressed by a sum of the rise time and the fall time thus obtained.

### (12b) Response Time (τ; Measured at 25° C.; ms)

Negative dielectric anisotropy: For measurement, an LCD5100 luminance meter made by Otsuka Electronics Co., Ltd. was used. A light source was a halogen lamp. A low-pass filter was set to 5 kHz. A sample was put in a normally black mode PVA device in which a distance (cell gap) between two glass substrates was 3.2 micrometers and a rubbing direction was anti-parallel. The device was sealed with an ultraviolet-curable adhesive. Voltage having a degree of slightly exceeding threshold voltage was applied to the device for 1 minute, and then the device was irradiated with ultraviolet light of 23.5 mW/cm² for 8 minutes while voltage of 5.6V was applied to the device. A voltage (rectangular waves; 60 Hz, 10 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A response time was expressed in terms of time required for a change from 90% transmittance to 10% transmittance (fall time; millisecond).

### (13) Voltage Holding Ratio

The polymerizable compound was polymerized by irradiating the device with ultraviolet light using a black light, F40T10/BL (peak wavelength of 369 nm) made by EYE GRAPHICS CO., LTD. The device was charged by applying a pulse voltage (60 microseconds at 1 V) at 60° C. A decaying voltage was measured for 1.67 seconds with a high-speed voltmeter, and area A between a voltage curve and a horizontal axis in a unit cycle was determined. Area B is an area without decay. A voltage holding ratio is expressed in terms of a percentage of area A to area B.

### Raw Material

Solmix (registered trademark) A-11 is a mixture of ethanol (85.5%), methanol (13.4%) and isopropanol (1.1%), and was purchased from Japan Alcohol Trading Co., Ltd.

### 2. Synthesis Example of Compound (1α)

### Synthesis Example 1α: Synthesis of Compound (1α-4-2)

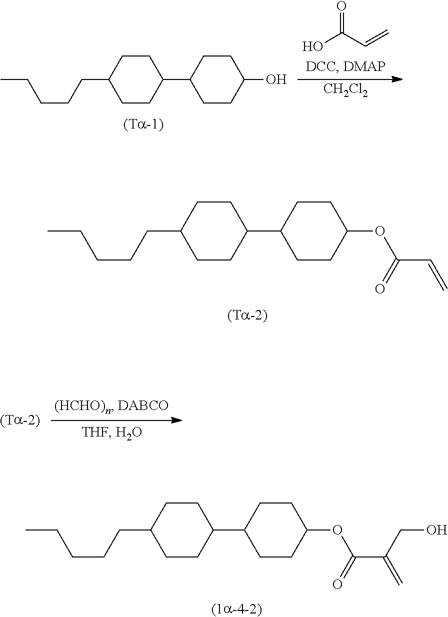

### First Step

Compound (Tα-1) (25.0 g), acrylic acid (7.14 g), DMAP (1.21 g) and dichloromethane (300 mL) were put in a reaction vessel, and the resulting mixture was cooled down to 0° C. A dichloromethane (125 mL) solution of DCC (24.5 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:toluene=2:1 in a volume ratio). The residue was further purified by recrystallization from Solmix (registered trademark) A-11 to obtain compound (Tα-2) (11.6 g; 38%).

### Second Step

Paraformaldehyde (2.75 g), DABCO (4.62 g) and water (40 mL) were put in a reaction vessel, and the resulting mixture was stirred at room temperature for 15 minutes. A THF (90 mL) solution of compound (Tα-2) (6.31 g) was added dropwise thereto, and the resulting mixture was stirred at room temperature for 72 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=5:1 in a volume ratio). The residue was further purified by recrystallization from a mixed solvent of heptane and toluene (1:1 in a volume ratio) to obtain compound (1α-4-2) (1.97 g; 29%).

An NMR analysis value of the resulting compound (1α-4-2) was as described below.

¹H-NMR: chemical shift δ (ppm; CDCl₃): 6.23 (s, 1H), 5.79 (d, J=1.2 Hz, 1H), 4.79-4.70 (m, 1H), 4.32 (d, J=6.7 Hz, 2H), 2.29 (t, J=6.7 Hz, 1H), 2.07-2.00 (m, 2H), 1.83-1.67 (m, 6H), 1.42-1.18 (m, 8H), 1.18-0.91 (m, 9H), 0.91-0.79 (m, 5H).

Physical properties of compound (1α-4-2) were as described below.

Transition temperature: C 40.8 S_{A} 109 I.

### Synthesis Example 2α: Synthesis of Compound (1α-4-22)

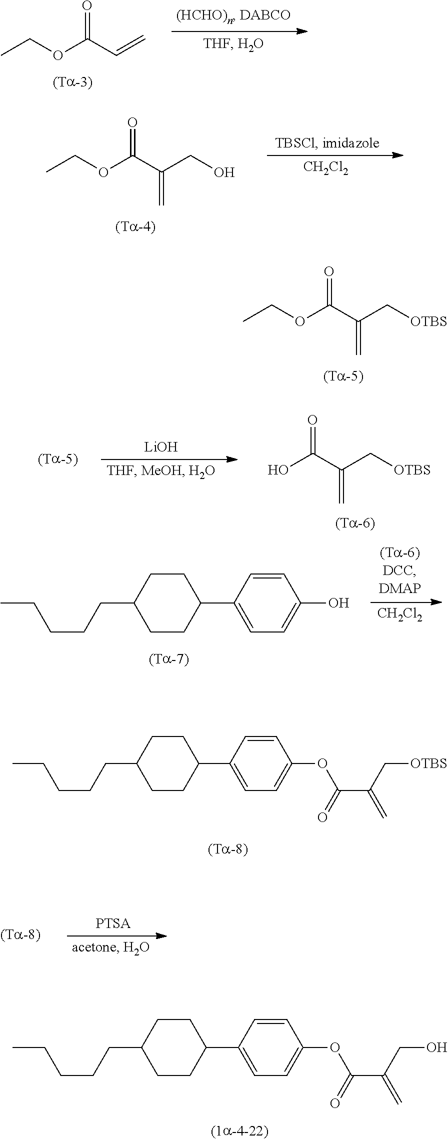

### First Step

Compound (Tα-4) (42.5 g; 65%) was obtained by using compound (Tα-3) (50.0 g) as a raw material in a manner similar to the technique in the second step in Synthesis Example 1α.

### Second Step

Compound (Tα-4) (42.5 g), imidazole (24.5 g) and dichloromethane (740 mL) were put in a reaction vessel, and the resulting mixture was cooled down to 0° C. A dichloromethane (110 mL) solution of t-butyldimethylsilyl chloride (54.1 g) was slowly added dropwise thereto, and the resulting mixture was stirred for 12 hours while returning to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=10:1 in a volume ratio) to obtain compound (Tα-5) (79.8 g; 100%).

### Third Step

Compound (Tα-5) (79.8 g), THF (640 mL), methanol (160 mL) and water (80 mL) were put in a reaction vessel, and the resulting mixture was cooled down to 0° C. Lithium hydroxide monohydrate (27.4 g) was added thereto, and the resulting mixture was stirred for 12 hours while returning to room temperature. The resulting reaction mixture was poured into water, and 6 N hydrochloric acid (15 mL) was slowly added thereto to acidify the resulting mixture, and then an aqueous layer was subjected to extraction with ethyl acetate. A combined organic layer was washed with water and dried over anhydrous magnesium sulfate. The solution was concentrated under reduced pressure to obtain compound (Tα-6) (60.6 g; 86%).

### Fourth Step

Compound (Tα-7) (2.83 g), compound (Tα-6) (2.98 g), DMAP (0.140 g) and dichloromethane (80 mL) were put in a reaction vessel, and the resulting mixture was cooled down to 0° C. A dichloromethane (40 mL) solution of DCC (2.84 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:toluene=2:1 in a volume ratio) to obtain compound (Tα-8) (3.22 g; 63%).

### Fifth Step

Compound (Tα-8) (3.22 g), p-toluenesulfonic acid monohydrate (PTSA, 0.551 g), acetone (50 mL) and water (3.5 mL) were put in a reaction vessel, and the resulting mixture was stirred at room temperature for 1 hour. Next, pyridine (0.30 mL) was added thereto, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (heptane:ethyl acetate=2:1 in a volume ratio). The residue was further purified by recrystallization from a mixed solvent of heptane and toluene (1:1 in a volume ratio) to obtain compound (1α-4-22) (2.05 g; 86%).

An NMR analysis value of the resulting compound (1α-4-22) was as described below.

¹H-NMR: chemical shift δ (ppm; CDCl₃): 7.23 (d, J=8.6 Hz, 2H), 7.03 (d, J=8.6 Hz, 2H), 6.50 (s, 1H), 6.03 (d, J=1.0 Hz, 1H), 4.44 (d, J=6.7 Hz, 2H), 2.47 (tt, J=12.2 Hz, J=3.3 Hz, 1H), 2.24 (t, J=6.6 Hz, 1H), 1.93-1.83 (m, 4H), 1.48-1.37 (m, 2H), 1.37-1.18 (m, 9H), 1.10-0.98 (m, 2H), 0.90 (t, J=7.2 Hz, 3H).

Physical properties of compound (1α-4-22) were as described below.

Transition temperature: C 67.6 S_{C} 84.4 S_{A} 87.7 N 89.8 I.

### Synthesis Example 3α: Synthesis of Compound (1α-4-27)

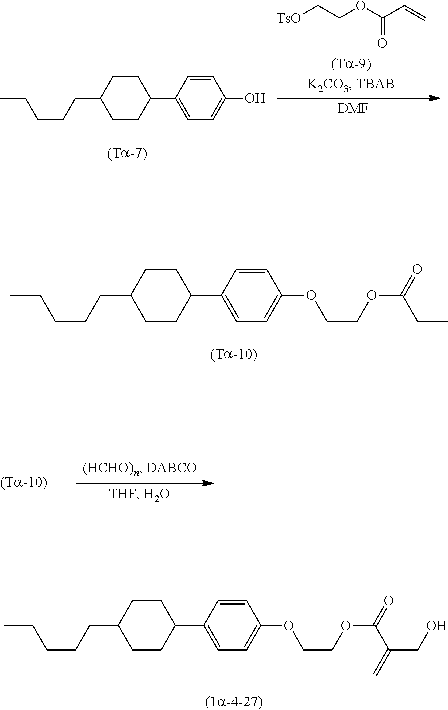

### First Step

Compound (Tα-7) (4.00 g), potassium carbonate (4.49 g), tetrabutylammonium bromide (TBAB) (1.05 g) and DMF (60 mL) were put in a reaction vessel, and the resulting mixture was stirred at 80° C. for 1 hour. A DMF (20 mL) solution of compound (Tα-9) (5.27 g) prepared according to a technique described in JP 2011-21118 A was slowly added dropwise thereto, and the resulting mixture was further stirred at 80° C. for 2 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (heptane:toluene=2:1 in a volume ratio) to obtain compound (Tα-10) (4.00 g; 72%).

### Second Step

Compound (1α-4-27) (1.81 g; 42%) was obtained by using compound (Tα-10) (4.00 g) as a raw material in a manner similar to the technique in the second step in Synthesis Example 1α.

An NMR analysis value of the resulting compound (1α-4-27) was as described below.

¹H-NMR: chemical shift δ (ppm; CDCl₃): 7.13 (d, J=8.6 Hz, 2H), 6.84 (d, J=8.7 Hz, 2H), 6.29 (s, 1H), 5.85 (d, J=1.2 Hz, 1H), 4.52 (t, J=4.8 Hz, 2H), 4.33 (d, J=6.7 Hz, 2H), 4.21 (t, J=4.8 Hz, 2H), 2.41 (tt, J=12.3 Hz, J=3.0 Hz, 1H), 2.26 (t, J=6.6 Hz, 1H), 1.90-1.81 (m, 4H), 1.46-1.17 (m, 11H), 1.09-0.98 (m, 2H), 0.89 (t, J=7.3 Hz, 3H).

Physical properties of compound (1α-4-27) were as described below.

Transition temperature: C 40.4 S_{A} 69.9 I.

### Synthesis Example 4α: Synthesis of Compound (1α-5-31)

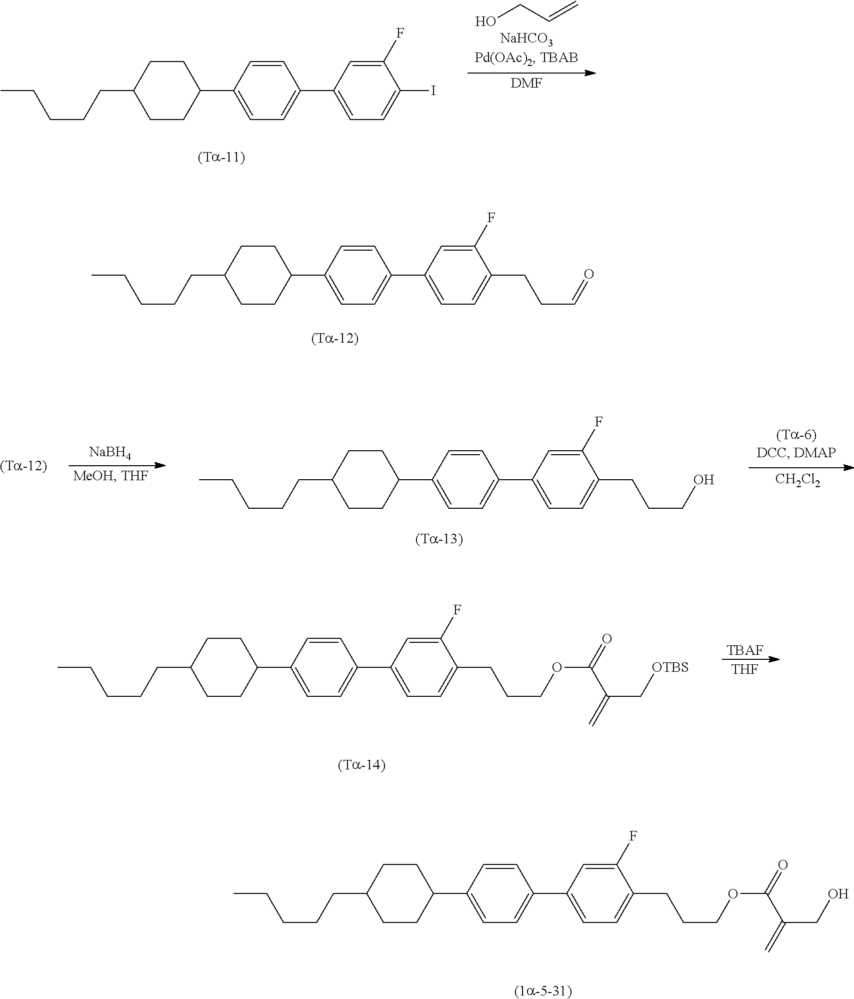

### First Step

Compound (Tα-11) (10.7 g) prepared according to a technique described in WO 2008/105286A, allyl alcohol (3.3 mL), palladium acetate (0.107 g), sodium hydrogencarbonate (5.99 g), TBAB (8.42 g) and DMF (110 mL) were put in a reaction vessel, and the resulting mixture was stirred at 40° C. for 8 hours. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene). The residue was further purified by recrystallization from a mixed solvent of heptane and toluene (1:1 in a volume ratio) to obtain compound (Tα-12) (6.93 g; 77%).

### Second Step

Sodium borohydride (0.723 g) and methanol (110 mL) were put in a reaction vessel, and the resulting mixture was cooled down to 0° C. A THF (30 mL) solution of compound (Tα-12) (6.93 g) was slowly added thereto, and the resulting mixture was stirred for 2 hours while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=5:1 in a volume ratio). The residue was further purified by recrystallization from a mixed solvent of heptane and toluene (1:1 in a volume ratio) to obtain compound (Tα-13) (5.73 g; 82%).

### Third Step

Compound (Tα-14) (3.36 g; 47%) was obtained by using compound (Tα-13) (4.73 g) as a raw material in a manner similar to the technique in the fourth step in Synthesis Example 2α.

### Fourth Step

Compound (Tα-14) (2.36 g) and THF (50 mL) were put in a reaction vessel, and the resulting mixture was cooled down to 0° C. TBAF (1.00 M; THF solution; 4.5 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=5:1 in a volume ratio). The residue was further purified by recrystallization from a mixed solvent of heptane and toluene (1:1 in a volume ratio) to obtain compound (1α-5-31) (1.47 g; 77%).

An NMR analysis value of the resulting compound (1α-5-31) was as described below.

¹H-NMR: chemical shift δ (ppm; CDCl₃): 7.48 (d, J=8.2 Hz, 2H), 7.31-7.14 (m, 5H), 6.25 (s, 1H), 5.84 (d, J=1.2 Hz, 1H), 4.34 (d, J=6.4 Hz, 2H), 4.24 (t, J=6.4 Hz, 2H), 2.78 (t, J=7.5 Hz, 2H), 2.51 (tt, J=12.1 Hz, J=3.2 Hz, 1H), 2.20 (t, J=6.5 Hz, 1H), 2.10-2.20 (m, 2H), 1.96-1.84 (m, 4H), 1.54-1.42 (m, 2H), 1.38-1.20 (m, 9H), 1.13-1.01 (m, 2H), 0.90 (t, J=7.2 Hz, 3H).

Physical properties of compound (1α-5-31) were as described below.

Transition temperature: S_{A} 115 I.

### Synthesis Example 5α: Synthesis of Compound (1α-3-1)

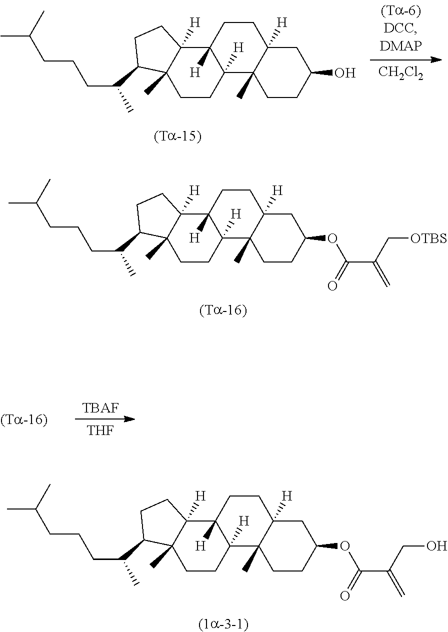

### First Step

Compound (Tα-16) (3.56 g; 24%) was obtained by using compound (Tα-15) (10.0 g) as a raw material in a manner similar to the technique in the fourth step in Synthesis Example 2α.

### Second Step

Compound (1α-3-1) (2.34 g; 82%) was obtained by using compound (Tα-16) (3.56 g) as a raw material in a manner similar to the technique in the fourth step in Synthesis Example 4α.

An NMR analysis value of the resulting compound (1α-3-1) was as described below.

¹H-NMR: chemical shift δ (ppm; CDCl₃): 6.23 (s, 1H), 5.79 (d, J=1.1 Hz, 1H), 4.87-4.76 (m, 1H), 4.32 (d, J=6.6 Hz, 2H), 2.26 (t, J=6.5 Hz, 1H), 1.97 (dt, J=12.6 Hz, J=3.2 Hz, 1H), 1.90-1.72 (m, 3H), 1.69-0.81 (m, 38H), 0.70-0.61 (m, 4H).

Physical properties of compound (1α-3-1) were as described below.

Transition temperature: C 122 I.

### Synthesis Example 6α: Synthesis of Compound (1α-4-82)

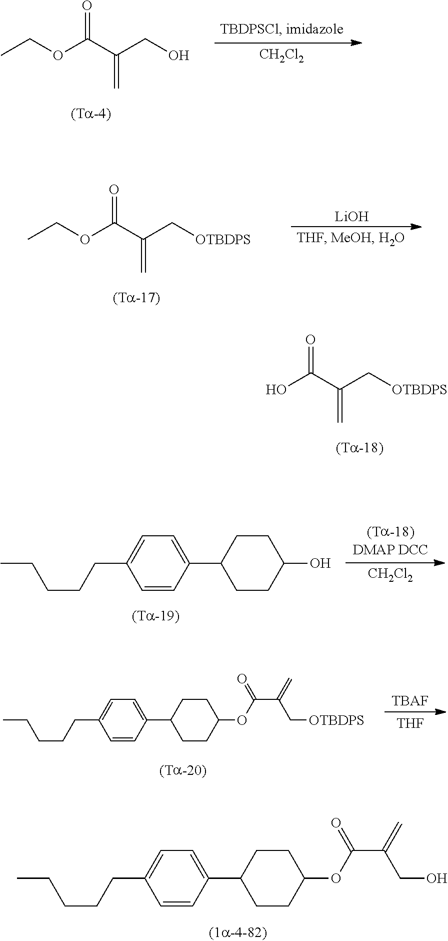

### First Step

Compound (Tα-4) (50.0 g) was used as a raw material, imidazole (28.7 g) and dichloromethane (800 mL) were put in a reaction vessel, and the resulting mixture was cooled down to 0° C. A dichloromethane (110 mL) solution of t-butyldiphenylchlorosilane (116.1 g) was slowly added dropwise thereto, and the resulting mixture was stirred for 12 hours while returning to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=10:1 in a volume ratio) to obtain compound (Tα-17) (127.4 g; 90%).

### Second Step

Compound (Tα-18) (63.6 g; 54%) was obtained by using compound (Tα-17) (127.4 g) as a raw material in a manner similar to the technique in the third step in Synthesis Example 2α.

### Third Step

Compound (Tα-19) (5.00 g), compound (Tα-18) (8.29 g), DMAP (1.0 g) and dichloromethane (80 mL) were put in a reaction vessel, and the resulting mixture was cooled down to 0° C. A dichloromethane (40 mL) solution of DCC (5.00 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:toluene=1:1 in a volume ratio) to obtain compound (Tα-20) (8.66 g; 75%).

### Fourth Step

Compound (Tα-20) (8.66 g) and THF (50 mL) were put in a reaction vessel, and the resulting mixture was cooled down to 0° C. TBAF (1.00 M; THF solution; 18 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (1α-4-82) (4.43 g; 88%).

An NMR analysis value of the resulting compound (1α-4-82) was as described below.

¹H-NMR: chemical shift δ (ppm; CDCl₃): 7.11 (s, 4H), 6.26 (s, 1H), 5.82 (d, J=1.1 Hz, 1H), 4.92-4.87 (m, 1H), 4.34 (d, J=6.4 Hz, 2H), 2.58-2.48 (m, 3H), 2.34-2.33 (m, 1H), 2.15-2.13 (m, 2H), 1.98-1.93 (m, 2H), 1.65-1.52 (m, 6H), 1.37-1.25 (m, 4H), 0.89 (t, J=6.8 Hz, 3H).

Physical properties of compound (1α-4-82) were as described below.

Transition temperature: C 44.0 (S_{A} 40.0) I

### Synthesis Example 7α: Synthesis of Compound (1α-4-41)

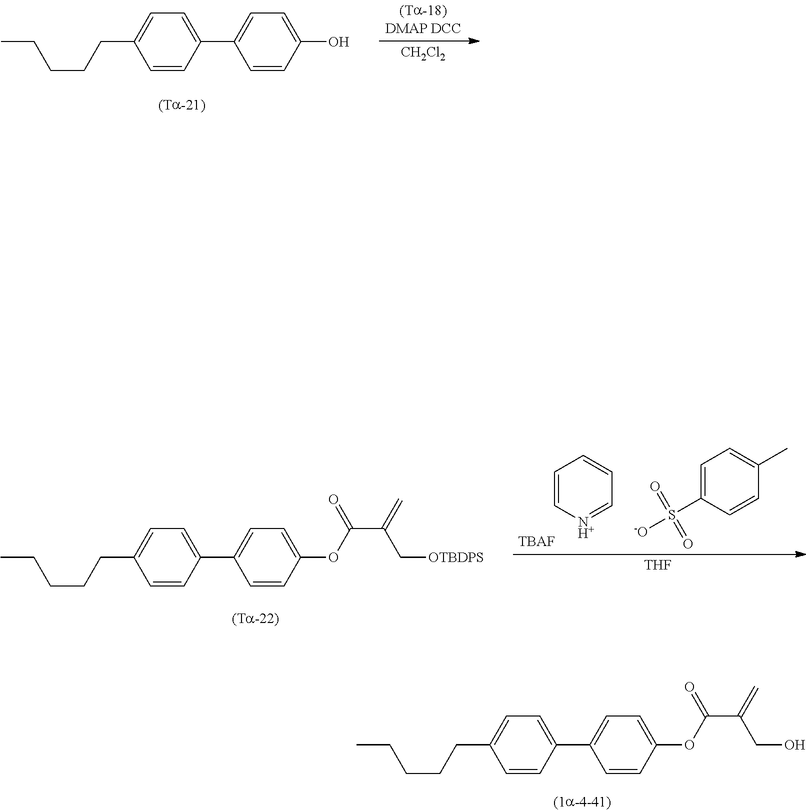

### First Step

Compound (Tα-22) (9.13 g; 78%) was obtained by using compound (Tα-21) (5.00 g) as a raw material in a manner similar to the technique in the third step in Synthesis Example 6α.

### Second Step

Compound (Tα-22) (9.13 g) and THF (50 mL) were put in a reaction vessel, and the resulting mixture was cooled down to 0° C. Pyridinium p-toluenesulfonate (4.89 g) and TBAF (1.00 M; THF solution; 19 mL) were slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from a mixed solvent of heptane and toluene (1:1 in a volume ratio) to obtain compound (1α-4-41) (4.53 g; 86%).

An NMR analysis value of the resulting compound (1α-4-41) was as described below.

¹H-NMR: chemical shift δ (ppm; CDCl₃): 7.60 (d, J=8.7 Hz, 2H), 7.48 (d, J=8.1 Hz, 2H), 7.25 (d, J=8.1 Hz, 2H), 7.18 (d, J=8.7 Hz, 2H), 6.54 (s, 1H), 6.06 (d, J=0.8 Hz, 1H), 4.46 (d, J=6.5 Hz, 2H), 2.64 (t, J=7.6 Hz, 2H), 2.28-2.26 (m, 1H), 1.66-1.63 (m, 2H), 1.36-1.33 (m, 4H), 0.90 (t, J=6.8 Hz, 3H).

Physical properties of compound (1α-4-41) were as described below.

Transition temperature: C 66.7 S_{A} 135.1 I.

### Synthesis Example 8α: Synthesis of Compound (1α-6-121)

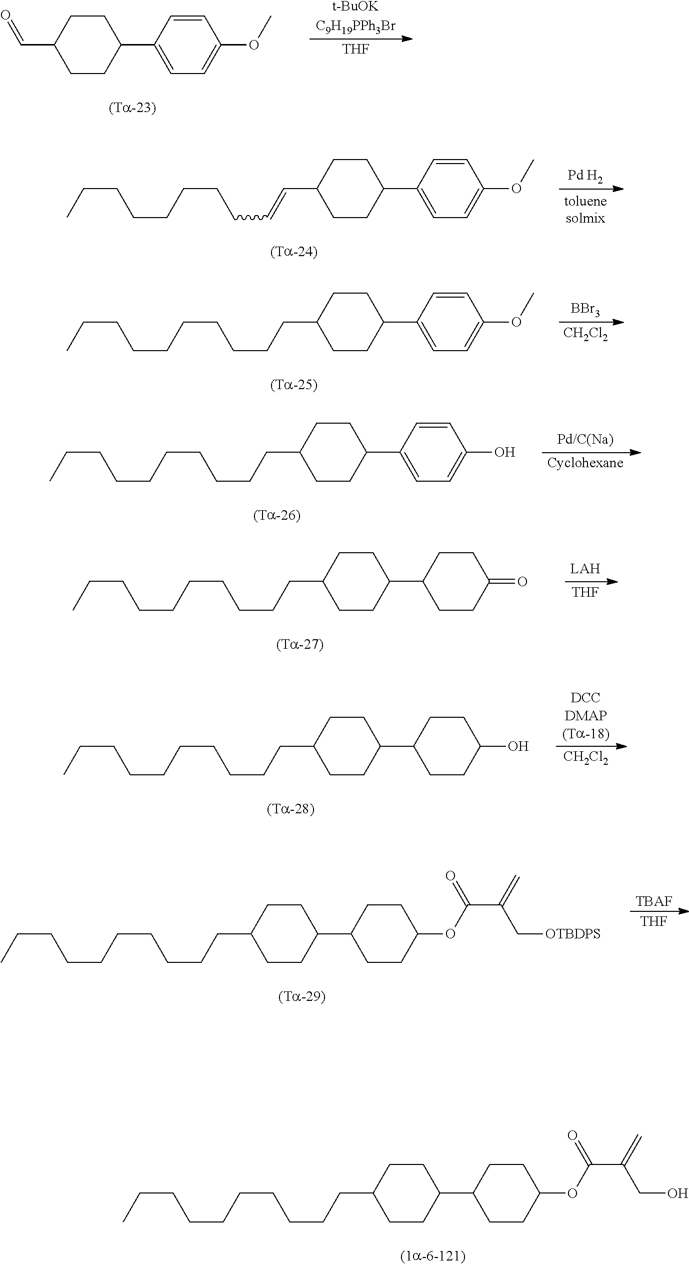

### First Step

Decyltriphenylphosphonium bromide (50.0 g) and THF (200 mL) were put in a reaction vessel, and the resulting mixture was cooled down to −30° C. Potassium t-butoxide (11.9 g) was slowly added thereto, and the resulting mixture was stirred at −30° C. for 1 hour. A THF (50 mL) solution of compound (Tα-23) (19.3 g) prepared according to a technique described in WO 2012/058187 A was added thereto. The resulting mixture was stirred for 5 hours while returning to room temperature. The resulting reaction mixture was poured into water, and an aqueous layer was subjected to extraction with toluene. A combined organic layer was washed with brine and dried over anhydrous magnesium sulfate. The solution was concentrated under reduced pressure, and the residue was purified by silica gel chromatography (heptane:toluene=4:1 in a volume ratio) to obtain compound (Tα-24) (23.9 g; 82%).

### Second Step

Compound (Tα-24) (23.9 g), toluene (400 mL) and IPA (400 mL) were put in a reaction vessel, Pd/C (0.38 g) was added thereto, and the resulting mixture was stirred at room temperature for 12 hours under a hydrogen atmosphere. The resulting reaction mixture was poured into water, and an aqueous layer was subjected to extraction with toluene. A combined organic layer was washed with brine and dried over anhydrous magnesium sulfate. The solution was concentrated under reduced pressure, and the residue was purified by silica gel chromatography (heptane:toluene=4:1 in a volume ratio) to obtain compound (Tα-25) (22.8 g; 95%).

### Third Step

Compound (Tα-25) (22.8 g) and dichloromethane (300 mL) were put in a reaction vessel, and the resulting mixture was cooled with ice. Boron tribromide (1.00 M; dichloromethane solution; 76 mL) was added thereto, and the resulting mixture was stirred for 5 hours while returning to room temperature. The resulting reaction mixture was poured into water, and an aqueous layer was subjected to extraction with dichloromethane. A combined organic layer was washed with brine and dried over anhydrous magnesium sulfate. The solution was concentrated under reduced pressure, and the residue was purified by silica gel chromatography with toluene. The residue was further purified by recrystallization from heptane to obtain compound (Tα-26) (18.8 g; 86%).

### Fourth Step

Compound (Tα-26) (18.8 g) and cyclohexane (400 mL) were put in an autoclave, and the resulting mixture was stirred at 70° C. for 6 hours. The resulting reaction mixture was poured into water, and an aqueous layer was subjected to extraction with toluene. A combined organic layer was washed with brine and dried over anhydrous magnesium sulfate. The solution was concentrated under reduced pressure, and the residue was purified by silica gel chromatography with toluene to obtain compound (Tα-27) (17.1 g; 90%).

### Fifth Step

Lithium aluminum hydride (1.21 g) and THF (200 mL) were put in a reaction vessel, and the resulting mixture was cooled with ice. A THF (200 mL) solution of compound (Tα-27) (17.1 g) was slowly added thereto, and the resulting mixture was stirred for 2 hours while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (Tα-28) (14.2 g; 83%).

### Sixth Step

Compound (Tα-29) (10.1 g; 84%) was obtained by using compound (Tα-28) (6.0 g) as a raw material in a manner similar to the technique in the third step in Synthesis Example 6α.

### Seventh Step

Compound (1α-6-121) (5.48 g; 86%) was obtained by using compound (Tα-29) (10.1 g) as a raw material in a manner similar to the technique in the fourth step in Synthesis Example 6α.

An NMR analysis value of the resulting compound (1α-6-121) was as described below.

¹H-NMR: chemical shift δ (ppm; CDCl₃): 6.23 (s, 1H), 5.79 (d, J=0.8 Hz, 1H), 4.77-4.71 (m, 1H), 4.32 (d, J=6.5 Hz, 2H), 2.31 (t, J=6.6 Hz, 1H), 2.04-2.02 (m, 2H), 1.80-1.68 (m, 6H), 1.39-1.25 (m, 18H), 1.13-0.80 (m, 14H).

Physical properties of compound (1α-6-121) were as described below.

Transition temperature: C 79.8 S_{A} 122.0 I.

### Synthesis Example 9α: Synthesis of Compound (1α-4-4)

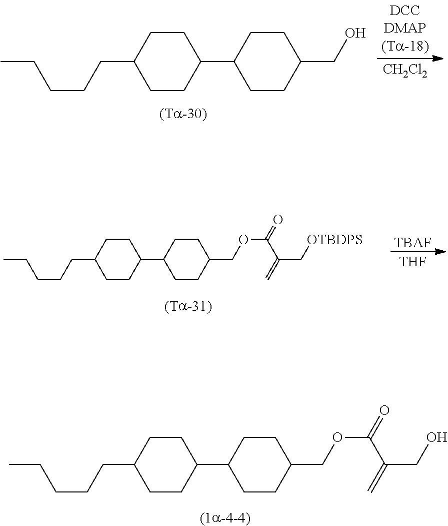

### First Step

Compound (Tα-31) (8.84 g; 80%) was obtained by using compound (Tα-30) (5.00 g) as a raw material in a manner similar to the technique in the third step in Synthesis Example 6α.

### Second Step

Compound (1α-4-4) (4.26 g; 81%) was obtained by using compound (Tα-31) (8.84 g) as a raw material in a manner similar to the technique in the fourth step in Synthesis Example 6α.

An NMR analysis value of the resulting compound (1α-4-4) was as described below.

¹H-NMR: chemical shift δ (ppm; CDCl₃): 6.25 (s, 1H), 5.82 (d, J=1.1 Hz, 1H), 4.33 (d, J=6.6 Hz, 2H), 3.99 (d, J=6.5 Hz, 2H), 2.33 (t, J=6.7 Hz, 1H), 1.80-1.62 (m, 9H), 1.32-0.80 (m, 22H).

Physical properties of compound (1α-4-4) were as described below.

Transition temperature: C 51.9 S_{A} 72.5 I.

### Synthesis Example 10α: Synthesis of Compound (1α-4-108)

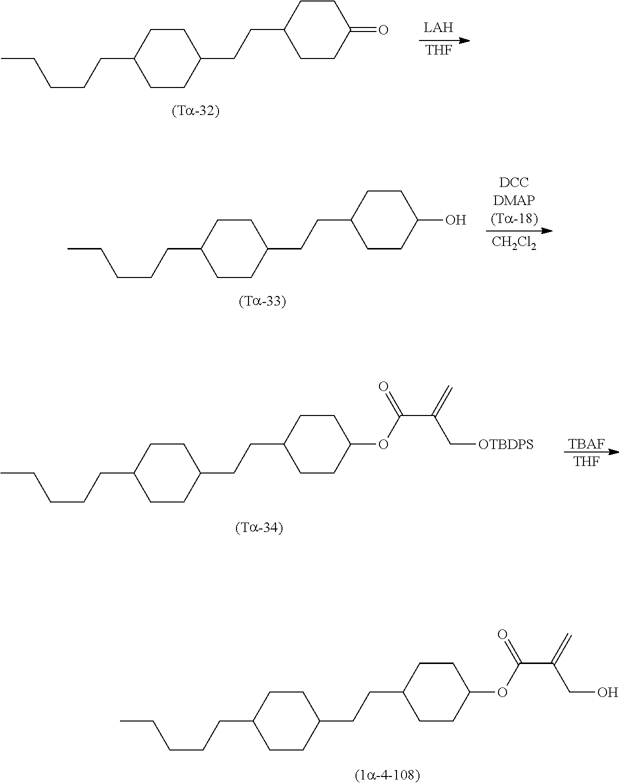

### First Step

Compound (Tα-33) (4.13 g; 82%) was obtained by using compound (Tα-32) (5.00 g) as a raw material in a manner similar to the technique in the fifth step in Synthesis Example 8α.

### Second Step

Compound (Tα-34) (7.10 g; 80%) was obtained by using compound (Tα-33) (4.13 g) as a raw material in a manner similar to the technique in the third step in Synthesis Example 6α.

### Third Step

Compound (1α-4-108) (3.65 g; 85%) was obtained by using compound (Tα-34) (7.10 g) as a raw material in a manner similar to the technique in the fourth step in Synthesis Example 6α.

An NMR analysis value of the resulting compound (1α-4-108) was as described below.

¹H-NMR: chemical shift δ (ppm; CDCl₃): 6.22 (s, 1H), 5.79 (d, J=1.1 Hz, 1H), 4.79-4.73 (m, 1H), 4.31 (d, J=6.7 Hz, 2H), 2.32 (t, J=6.5 Hz, 1H), 2.02-1.99 (m, 2H), 1.82-1.79 (m, 2H), 1.72-1.70 (m, 4H), 1.42-0.98 (m, 19H), 0.89-0.80 (m, 7H).

Physical properties of compound (1α-4-108) were as described below.

Transition temperature: C 46.1 S_{A} 122 I.

### Synthesis Example 11α: Synthesis of Compound (1α-4-5)

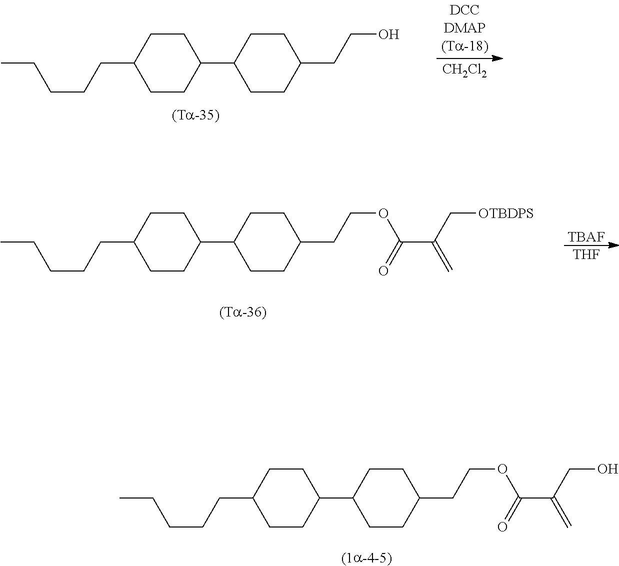

### First Step

Compound (Tα-36) (8.60 g; 80%) was obtained by using compound (Tα-35) (5.00 g) as a raw material in a manner similar to the technique in the third step in Synthesis Example 6α.

### Second Step

Compound (1α-4-5) (4.21 g; 81%) was obtained by using compound (Tα-36) (8.60 g) as a raw material in a manner similar to the technique in the fourth step in Synthesis Example 6α.

An NMR analysis value of the resulting compound (1α-4-5) was as described below.

¹H-NMR: chemical shift δ (ppm; CDCl₃): 6.24 (s, 1H), 5.82 (d, J=1.1 Hz, 1H), 4.33 (d, J=6.6 Hz, 2H), 4.21 (t, J=6.8 Hz, 2H), 2.29-2.26 (m, 1H), 1.78-1.67 (m, 8H), 1.60-1.55 (m, 2H), 1.31-1.07 (m, 10H), 1.00-0.79 (m, 13H).

Physical properties of compound (1α-4-5) were as described below.

Transition temperature: C 69.4 S_{A} 124.6 I.

### Synthesis Example 12α: Synthesis of Compound (1α-4-6)

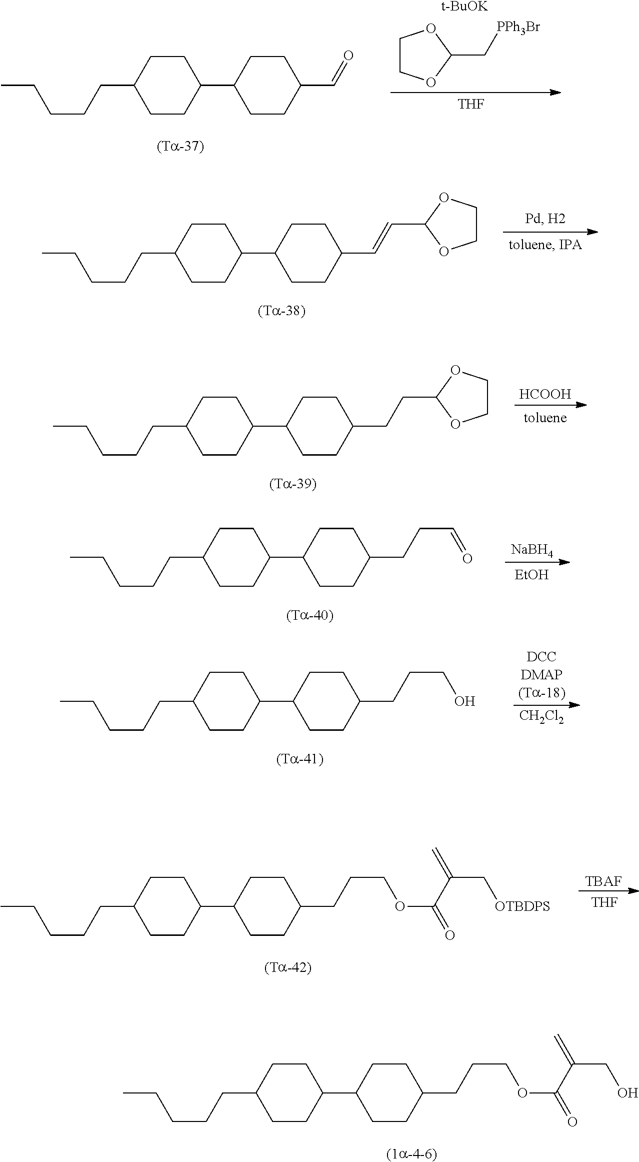

### First Step

Then, (1,3-dioxolan-2-yl)methyltriphenylphosphonium bromide (19.5 g) and THF (200 mL) were put in a reaction vessel, and the resulting mixture was cooled down to −30° C. Potassium t-butoxide (5.09 g) was added thereto, and the resulting mixture was stirred at −30° C. for 1 hour. Compound (Tα-37) (10.0 g) was added thereto, and the resulting mixture was stirred for 5 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-38) (11.4 g; 90%).

### Second Step

Compound (Tα-38) (11.4 g), Pd/C (0.18 g), IPA (200 mL) and toluene (200 mL) were put in a reaction vessel, and the resulting mixture was stirred at room temperature for 12 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-39) (10.6 g; 92%).

### Third Step

Compound (Tα-39) (10.6 g), formic acid (14.5 g) and toluene (200 mL) were put in a reaction vessel, and the resulting mixture was stirred at 100° C. for 4 hours. An insoluble matter was filtered off, and then the resulting material was neutralized with a sodium hydrogencarbonate aqueous solution, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-40) (8.11 g; 88%).

### Fourth Step

Sodium borohydride (0.62 g) and ethanol (100 mL) were put in a reaction vessel, and the resulting mixture was cooled down to 0° C. An ethanol (100 mL) solution of compound (Tα-40) (8.11 g) was added dropwise thereto. The resulting mixture was stirred for 4 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (Tα-41) (6.37 g; 78%).

### Fifth Step

Compound (Tα-42) (8.67 g; 65%) was obtained by using compound (Tα-41) (6.37 g) as a raw material in a manner similar to the technique in the third step in Synthesis Example 6α.

### Sixth Step

Compound (1α-4-6) (4.52 g; 85%) was obtained by using compound (Tα-42) (8.67 g) as a raw material in a manner similar to the technique in the fourth step in Synthesis Example 6α.

An NMR analysis value of the resulting compound (1α-4-6) was as described below.

¹H-NMR: chemical shift δ (ppm; CDCl₃): 6.25 (s, 1H), 5.82 (d, J=0.9 Hz, 1H), 4.33 (d, J=6.7 Hz, 2H), 4.15 (t, J=6.7 Hz, 2H), 2.27 (t, J=6.5 Hz, 1H), 1.76-1.62 (m, 10H), 1.32-1.06 (m, 12H), 1.02-0.79 (m, 13H).

Physical properties of compound (1α-4-6) were as described below.

Transition temperature: C 53.6 S_{A} 113 I.

### Synthesis Example 13α: Synthesis of Compound (1α-4-26)

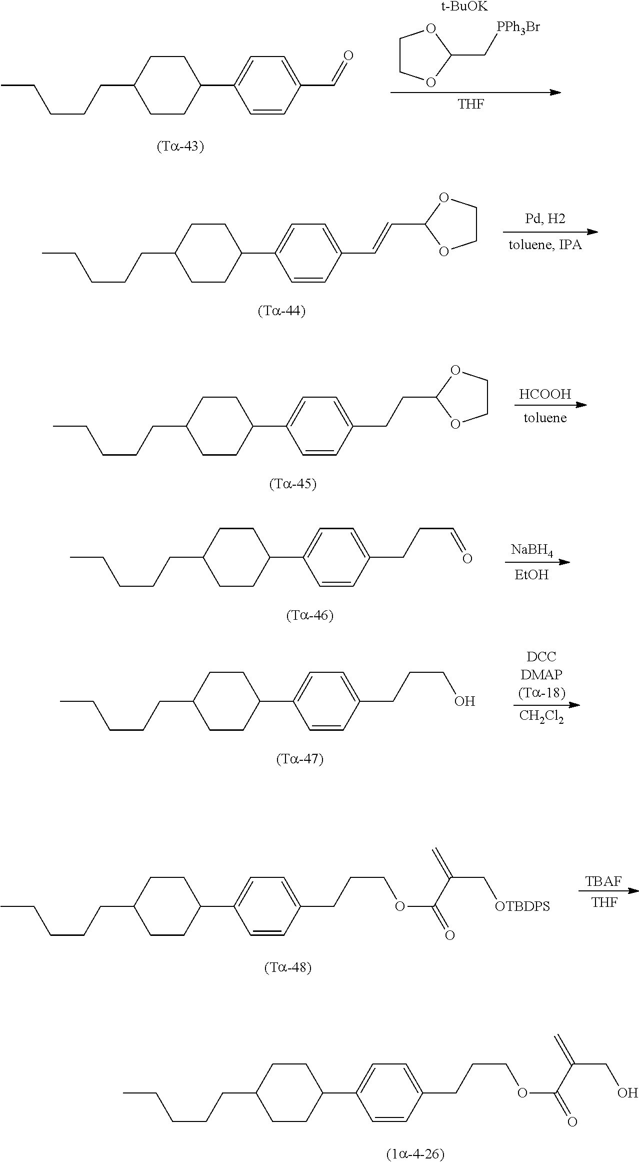

### First Step

Compound (Tα-44) (11.2 g; 88%) was obtained by using compound (Tα-43) (10.0 g) as a raw material in a manner similar to the technique in the first step in Synthesis Example 12α.

### Second Step

Compound (Tα-45) (10.1 g; 90%) was obtained by using compound (Tα-44) (11.2 g) as a raw material in a manner similar to the technique in the second step in Synthesis Example 12α.

### Third Step

Compound (Tα-46) (7.44 g; 85%) was obtained by using compound (Tα-45) (10.1 g) as a raw material in a manner similar to the technique in the third step in Synthesis Example 12α.

### Fourth Step

Compound (Tα-47) (6.07 g; 81%) was obtained by using compound (Tα-46) (7.44 g) as a raw material in a manner similar to the technique in the fourth step in Synthesis Example 12α.

### Fifth Step

Compound (Tα-48) (9.38 g; 73%) was obtained by using compound (Tα-47) (6.07 g) as a raw material in a manner similar to the technique in the third step in Synthesis Example 6α.

### Sixth Step

Compound (1α-4-26) (3.32 g; 58%) was obtained by using compound (Tα-48) (9.38 g) as a raw material in a manner similar to the technique in the fourth step in Synthesis Example 6α.

An NMR analysis value of the resulting compound (1α-4-26) was as described below.

¹H-NMR: chemical shift δ (ppm; CDCl₃): 7.13 (d, J=8.2 Hz, 2H), 7.10 (d, J=8.2 Hz, 2H), 6.23 (s, 1H), 5.82 (d, J=1.1 Hz, 1H), 4.32 (d, J=6.7 Hz, 2H), 4.20 (t, J=6.4 Hz, 2H), 2.68 (t, J=7.3 Hz, 2H), 2.43 (tt, J=12.2 Hz, J=3.2 Hz, 1H), 2.21 (t, J=6.8 Hz, 1H), 2.04-1.98 (m, 2H), 1.88-1.84 (m, 4H), 1.46-1.38 (m, 2H), 1.35-1.19 (m, 9H), 1.07-0.99 (m, 2H), 0.89 (t, J=7.2 Hz, 3H).

Physical properties of compound (1α-4-26) were as described below.

Transition temperature: C 41.4 I.

### Synthesis Example 14α: Synthesis of Compound (1α-6-122)

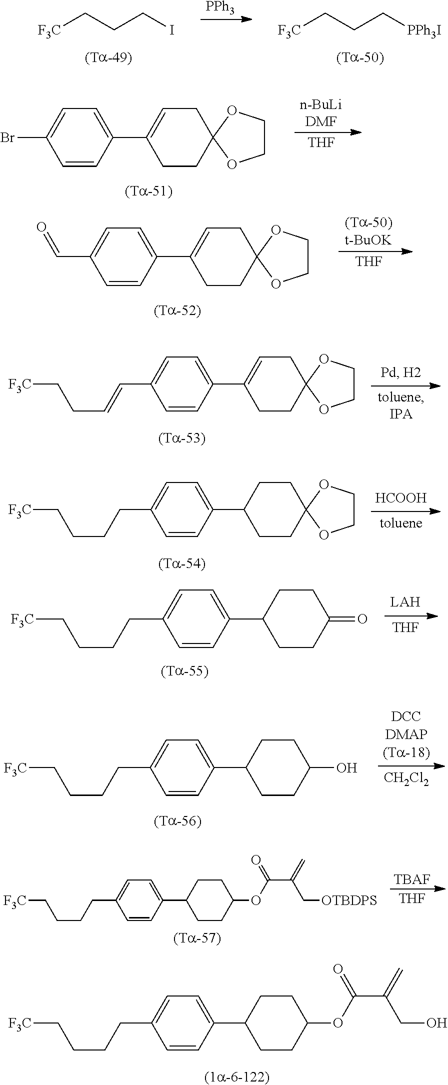

### First Step

Compound (Tα-49) (15.0 g) and triphenyl phosphine (24.8 g) were put in a reaction vessel, and the resulting mixture was stirred at 100° C. for 6 hours. The resulting product was filtrated and washed with heptane cooled with ice to obtain compound (Tα-50) (16.4 g; 52%).

### Second Step

Compound (Tα-51) (10.0 g) and THF (200 mL) were put in a reaction vessel, and the resulting mixture was cooled down to −70° C. N-butyllithium (1.63M; hexane solution; 25 mL) was slowly added thereto, and the resulting mixture was stirred for 1 hour. DMF (4.0 mL) was slowly added thereto, and the resulting mixture was stirred for 12 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tα-52) (6.37 g; 77%).

### Third Step

Compound (Tα-50) (14.3 g) and THF (200 mL) were put in a reaction vessel, and the resulting mixture was cooled down to −30. Potassium t-butoxide (3.21 g) was slowly added thereto, and the resulting mixture was stirred at −30° C. for 1 hour. A THF (100 mL) solution of compound (Tα-52) (6.37 g) was slowly added thereto, and the resulting mixture was stirred for 4 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-53) (7.50 g; 85%).

### Fourth Step

Compound (Tα-53) (7.50 g), Pd/C (0.11 g), IPA (200 mL) and toluene (200 mL) were put in a reaction vessel, and the resulting mixture was stirred at room temperature for 12 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-54) (7.21 g; 95%).

### Fifth Step

Compound (Tα-54) (7.21 g), formic acid (9.70 g) and toluene (200 mL) were put in a reaction vessel, and the resulting mixture was stirred at 100° C. for 4 hours. An insoluble matter was filtered off, and then the resulting material was neutralized with a sodium hydrogencarbonate aqueous solution, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-55) (5.65 g; 90%).

### Sixth Step

Lithium aluminum hydride (0.43 g) and THF (100 mL) were put in a reaction vessel, and the resulting mixture was cooled with ice. A THF (100 mL) solution of compound (Tα-55) (5.65 g) was slowly added thereto, and the resulting mixture was stirred for 2 hours while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (Tα-56) (4.83 g; 85%).

### Seventh Step

Compound (Tα-57) (8.41 g; 84%) was obtained by using compound (Tα-56) (4.83 g) as a raw material in a manner similar to the technique in the third step in Synthesis Example 6α.

### Eighth Step

Compound (1α-6-122) (3.22 g; 62%) was obtained by using compound (Tα-57) (8.41 g) as a raw material in a manner similar to the technique in the fourth step in Synthesis Example 6α.

An NMR analysis value of the resulting compound (1α-6-122) was as described below.

¹H-NMR: chemical shift δ (ppm; CDCl₃): 7.13 (d, J=8.2 Hz, 2H), 7.10 (d, J=8.2 Hz, 2H), 6.26 (s, 1H), 5.82 (d, J=1.1 Hz, 1H), 4.92-4.87 (m, 1H), 4.34 (d, J=6.7 Hz, 2H), 2.60 (t, J=7.3 Hz, 2H), 2.54-2.49 (m, 1H), 2.31 (t, J=6.5 Hz, 1H), 2.15-2.04 (m, 4H), 1.98-1.96 (m, 2H), 1.66-1.52 (m, 8H).

Physical properties of compound (1α-6-122) were as described below.

Transition temperature: C 62.0 I.

### Synthesis Example 15α: Synthesis of Compound (1α-6-123)

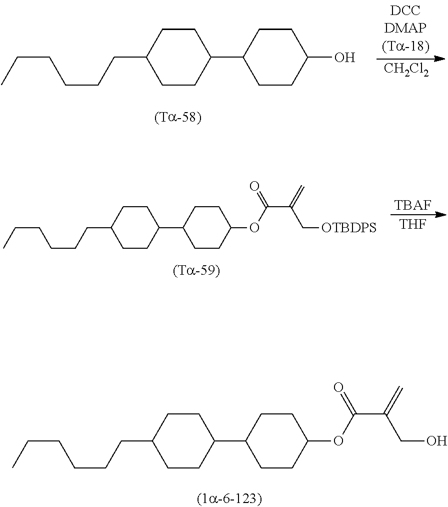

### First Step

Compound (Tα-59) (7.74 g; 70%) was obtained by using compound (Tα-58) (5.00 g) as a raw material in a manner similar to the technique in the third step in Synthesis Example 6α.

### Second Step

Compound (1α-6-123) (3.82 g; 83%) was obtained by using compound (Tα-59) (7.74 g) as a raw material in a manner similar to the technique in the fourth step in Synthesis Example 6α.

An NMR analysis value of the resulting compound (1α-6-123) was as described below.

¹H-NMR: chemical shift δ (ppm; CDCl₃): 6.22 (s, 1H), 5.79 (s, 1H), 4.77-4.71 (m, 1H), 4.31 (d, J=6.5 Hz, 2H), 2.29-2.26 (m, 1H), 2.04-2.01 (m, 2H), 1.80-1.68 (m, 6H), 1.39-1.24 (m, 10H), 1.13-0.80 (m, 14H).

Physical properties of compound (1α-6-123) were as described below.

Transition temperature: C 59.1 S_{A} 114 I.

### Synthesis Example 16α: Synthesis of Compound (1α-4-3)

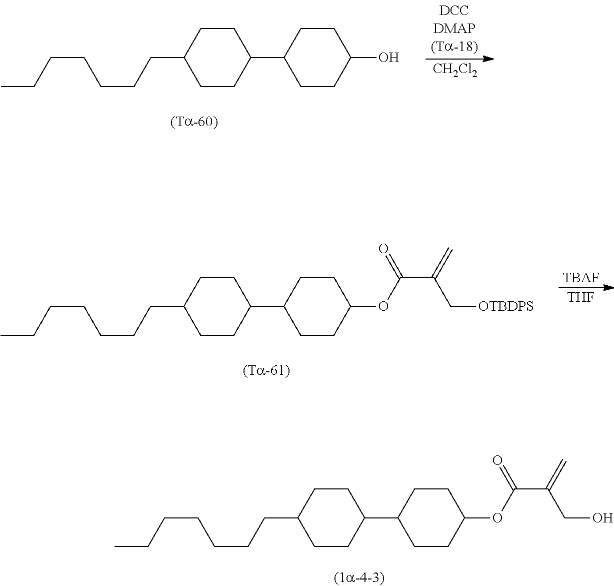

### First Step

Compound (Tα-61) (8.49 g; 79%) was obtained by using compound (Tα-60) (5.00 g) as a raw material in a manner similar to the technique in the third step in Synthesis Example 6α.

### Second Step

Compound (1α-4-3) (3.54 g; 69%) was obtained by using compound (Tα-61) (8.49 g) as a raw material in a manner similar to the technique in the fourth step in Synthesis Example 6α.

An NMR analysis value of the resulting compound (1α-4-3) was as described below.

¹H-NMR: chemical shift δ (ppm; CDCl₃): 6.22 (s, 1H), 5.79 (d, J=1.1 Hz, 1H), 4.76-4.72 (m, 1H), 4.31 (d, J=6.8 Hz, 2H), 2.29-2.26 (m, 1H), 2.04-2.01 (m, 2H), 1.80-1.68 (m, 6H), 1.40-1.25 (m, 12H), 1.16-0.80 (m, 14H).

Physical properties of compound (1α-4-3) were as described below.

Transition temperature: C 60.9 S_{A} 109 I.

### Synthesis Example 17α: Synthesis of Compound (1α-6-124)

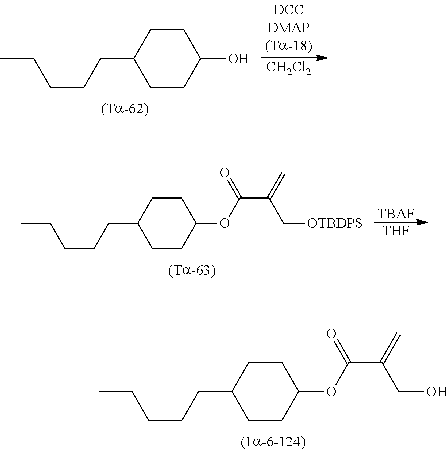

### First Step

Compound (Tα-63) (8.39 g; 58%) was obtained by using compound (Tα-62) (5.00 g) as a raw material in a manner similar to the technique in the third step in Synthesis Example α6.

### Second Step

Compound (1α-6-124) (3.85 g; 89%) was obtained by using compound (Tα-63) (8.39 g) as a raw material in a manner similar to the technique in the fourth step in Synthesis Example α6.

An NMR analysis value of the resulting compound (1α-6-124) was as described below.

¹H-NMR: chemical shift δ (ppm; CDCl₃): 6.22 (s, 1H), 5.80 (d, J=1.1 Hz, 1H), 4.78-4.72 (m, 1H), 4.31 (s, 2H), 2.74 (s, 1H), 2.02-1.98 (m, 2H), 1.82-1.79 (m, 2H), 1.42-1.16 (m, 11H), 1.07-0.97 (m, 2H), 0.88 (t, J=6.8 Hz, 3H).

Physical properties of compound (1α-6-124) were as described below.

Transition temperature: <−50.0 I.

### Synthesis Example 18α: Synthesis of Compound (1α-6-125)

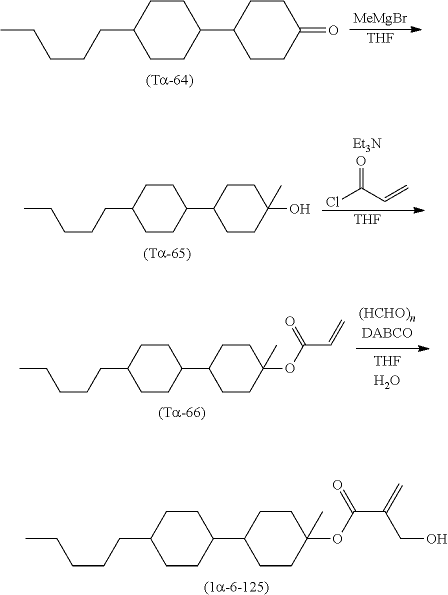

### First Step

Compound (Tα-64) (10.0 g) and THF (200 mL) were put in a reaction vessel, and the resulting mixture was cooled down to 0° C. Methylmagnesiumbromide (1.00 M; THF solution; 48 mL) was slowly added thereto, and the resulting mixture was stirred for 6 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tα-65) (4.58 g; 43%).

### Second Step

Compound (Tα-65) (4.58 g), triethylamine (2.87 mL) and THF (200 mL) were put in a reaction vessel, and the resulting mixture was cooled down to 0° C. Acryloylchloride (1.68 mL) was slowly added thereto, and the resulting mixture was stirred for 5 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=3:2 in a volume ratio) to obtain compound (Tα-66) (3.20 g; 58%).

### Third Step

Compound (1α-6-125) (1.12 g; 32%) was obtained by using compound (Tα-66) (3.20 g) as a raw material in a manner similar to the technique in the second step in Synthesis Example 1α.

An NMR analysis value of the resulting compound (1α-6-125) was as described below.

¹H-NMR: chemical shift δ (ppm; CDCl₃): 6.15 (s, 1H), 5.73 (d, J=1.2 Hz, 1H), 4.28 (d, J=6.6 Hz, 2H), 2.34-2.32 (m, 1H), 2.13-2.11 (m, 2H), 1.76-1.67 (m, 8H), 1.54 (s, 3H), 1.32-1.03 (m, 13H), 0.97-0.80 (m, 7H).

Physical properties of compound (1α-6-125) were as described below.

Transition temperature: C 66.5 S_{A} 81.1 I.

### Synthesis Example 19α: Synthesis of Compound (1α-6-126)

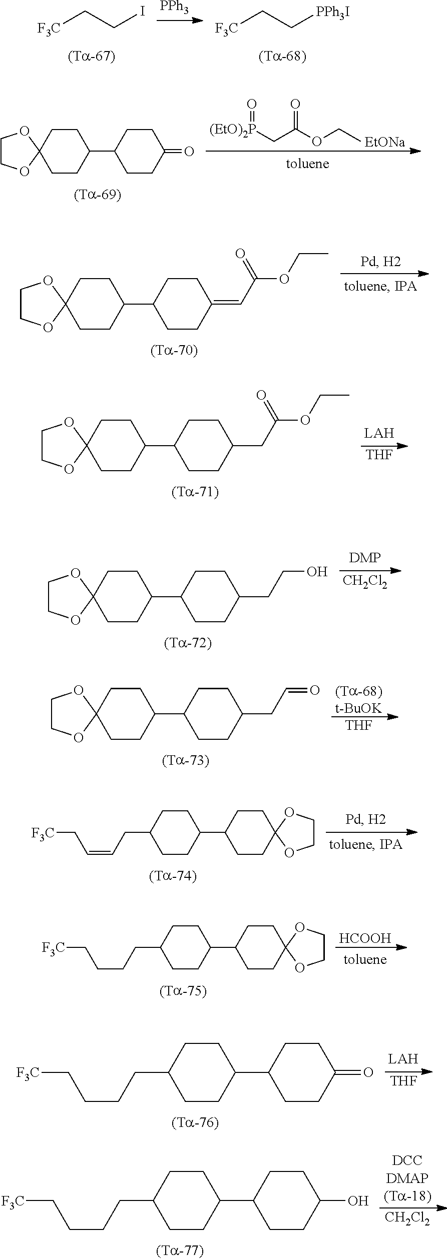

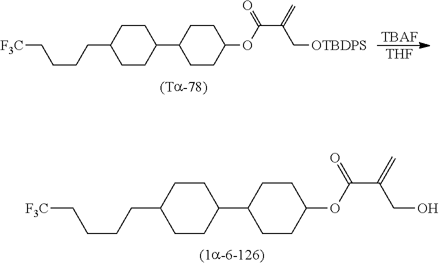

### First Step

Compound (Tα-67) (25.0 g) and triphenyl phosphine (43.9 g) were put in a reaction vessel, and the resulting mixture was stirred at 90° C. for 6 hours. The resulting product was filtrated and washed with heptane to obtain compound (Tα-68) (22.8 g; 42%).

### Second Step

Compound (Tα-69) (20.0 g), triethyl phosphonoacetate (22.5 g) and toluene (300 mL) were put in a reaction vessel, and the resulting mixture was cooled down to 0° C. Sodium ethoxide (20% ethanol solution) (34.2 g) was slowly added thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-70) (23.3 g; 90%).

### Third Step

Compound (Tα-70) (23.3 g), toluene (400 mL) and IPA (400 mL) were put in a reaction vessel, Pd/C (0.40 g) was added thereto, and the resulting mixture was stirred at room temperature for 12 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-71) (21.5 g; 92%).

### Fourth Step

Lithium aluminum hydride (1.57 g) and THF (200 mL) were put in a reaction vessel, and the resulting mixture was cooled with ice. A THF (200 mL) solution of compound (Tα-71) (21.5 g) was slowly added thereto, and the resulting mixture was stirred for 5 hours while returning to room temperature. An insoluble matter was filtered off, and then the resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=4:1 in a volume ratio) to obtain compound (Tα-72) (14.3 g; 77%).

### Fifth Step

Compound (Tα-72) (14.3 g) and dichloromethane (300 mL) were put in a reaction vessel, and the resulting mixture was cooled with ice. Dess-Martin Periodinane (27.1 g) was slowly added thereto, and the resulting mixture was stirred for 5 hours while returning to room temperature. An insoluble matter was filtered off, and then the resulting reaction mixture was poured into water, and an aqueous layer was subjected to extraction with dichloromethane. A combined organic layer was washed with brine and dried over anhydrous magnesium sulfate. The solution was concentrated under reduced pressure, and the residue was purified by silica gel chromatography (toluene:ethyl acetate=9:1 in a volume ratio) to obtain compound (Tα-73) (9.93 g; 70%).

### Sixth Step

Compound (Tα-68) (21.7 g) and THF (200 mL) were put in a reaction vessel, and the resulting mixture was cooled down to −30. Potassium t-butoxide (5.01 g) was slowly added thereto, and the resulting mixture was stirred at −30° C. for 1 hour. A THF (100 mL) solution of compound (Tα-73) (9.93 g) was slowly added thereto, and the resulting mixture was stirred for 5 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-74) (6.97 g; 54%).

### Seventh Step

Compound (Tα-74) (6.97 g), Pd/C (0.10 g), IPA (100 mL) and toluene (100 mL) were put in a reaction vessel, and the resulting mixture was stirred at room temperature for 12 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-75) (6.31 g; 90%).

### Eighth Step

Compound (Tα-76) (4.96 g; 90%) was obtained by using compound (Tα-75) (6.31 g) as a raw material in a manner similar to the technique in the fifth step in Synthesis Example 14α.

### Ninth Step

Compound (Tα-77) (4.24 g; 85%) was obtained by using compound (Tα-76) (4.96 g) as a raw material in a manner similar to the technique in the sixth step in Synthesis Example 14α.

### Tenth Step

Compound (Tα-78) (5.40 g; 62%) was obtained by using compound (Tα-77) (4.24 g) as a raw material in a manner similar to the technique in the third step in Synthesis Example 6α.

### Eleventh Step

Compound (1α-6-126) (2.37 g; 90%) was obtained by using compound (Tα-78) (4.24 g) as a raw material in a manner similar to the technique in the fourth step in Synthesis Example 6α.

An NMR analysis value of the resulting compound (1α-6-126) was as described below.

¹H-NMR: chemical shift δ (ppm; CDCl₃): 6.25 (s, 1H), 5.81 (d, J=0.8 Hz, 1H), 4.79-4.73 (m, 1H), 4.34 (d, J=6.7 Hz, 2H), 2.32-2.29 (m, 1H), 2.12-2.03 (m, 4H), 1.82-1.72 (m, 6H), 1.57-1.49 (m, 2H), 1.44-1.35 (m, 4H), 1.22-0.84 (m, 11H).

Physical properties of compound (1α-6-126) were as described below.

Transition temperature: C 72.0 S_{A} 81.1 I.

### Synthesis Example 20α: Synthesis of Compound (1α-6-127)

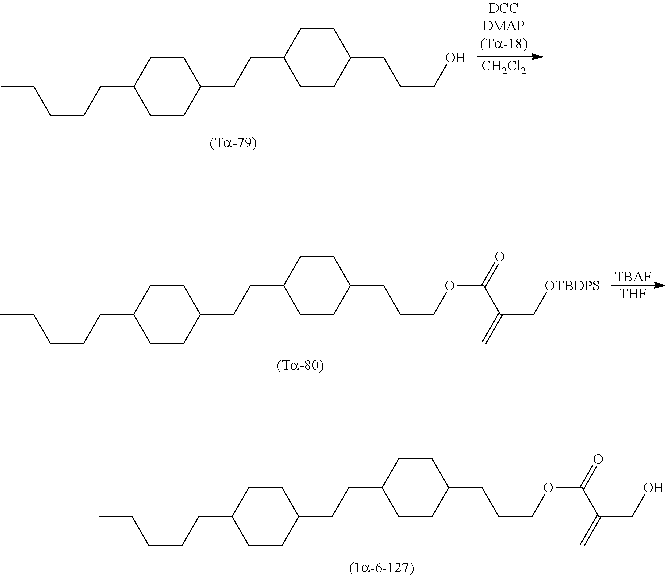

### First Step

Compound (Tα-80) (6.40 g; 64%) was obtained by using compound (Tα-79) (5.00 g) as a raw material in a manner similar to the technique in the third step in Synthesis Example 6α.

### Second Step

Compound (1α-6-127) (2.02 g; 50%) was obtained by using compound (Tα-80) (6.40 g) as a raw material in a manner similar to the technique in the fourth step in Synthesis Example 6α.

An NMR analysis value of the resulting compound (1α-6-127) was as described below.

¹H-NMR: chemical shift δ (ppm; CDCl₃): 6.24 (s, 1H), 5.82 (d, J=1.3 Hz, 1H), 4.33 (d, J=5.5 Hz, 2H), 4.15 (t, J=6.8 Hz, 2H), 2.39-2.37 (m, 1H), 1.73-1.66 (m, 10H), 1.32-1.09 (m, 18H), 0.91-0.80 (m, 11H).

Physical properties of compound (1α-6-127) were as described below.

Transition temperature: C 110 I.

### Synthesis Example 21α: Synthesis of Compound (1α-6-128)

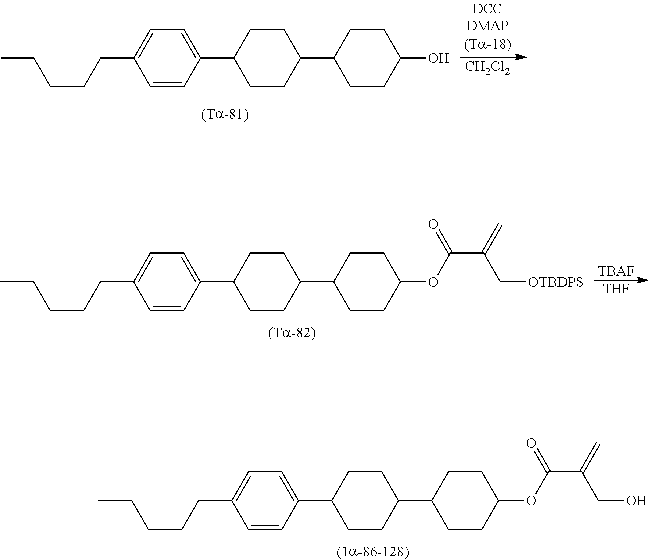

### First Step

Compound (Tα-82) (5.94 g; 60%) was obtained by using compound (Tα-81) (5.00 g) as a raw material in a manner similar to the technique in the third step in Synthesis Example 6α.

### Second Step

Compound (1α-6-128) (2.64 g; 70%) was obtained by using compound (Tα-82) (5.94 g) as a raw material in a manner similar to the technique in the fourth step in Synthesis Example 6α.

An NMR analysis value of the resulting compound (1α-6-128) was as described below.

¹H-NMR: chemical shift δ (ppm; CDCl₃): 7.12-7.08 (m, 4H), 6.23 (s, 1H), 5.80 (d, J=1.0 Hz, 1H), 4.78-4.74 (m, 1H), 4.32 (d, J=6.6 Hz, 2H), 2.55 (t, J=7.6 Hz, 2H), 2.41 (tt, J=12.1 Hz, J=3.3 Hz, 1H), 2.28 (t, J=6.5 Hz, 1H), 2.07-2.04 (m, 2H), 1.93-1.90 (m, 2H), 1.85-1.82 (m, 4H), 1.61-1.57 (m, 2H), 1.44-1.30 (m, 8H), 1.20-1.13 (m, 6H), 0.88 (t, J=6.8 Hz, 3H).

Physical properties of compound (1α-6-128) were as described below.

Transition temperature: C 85.0 I.

### Synthesis Example 22α: Synthesis of Compound (1α-6-129)

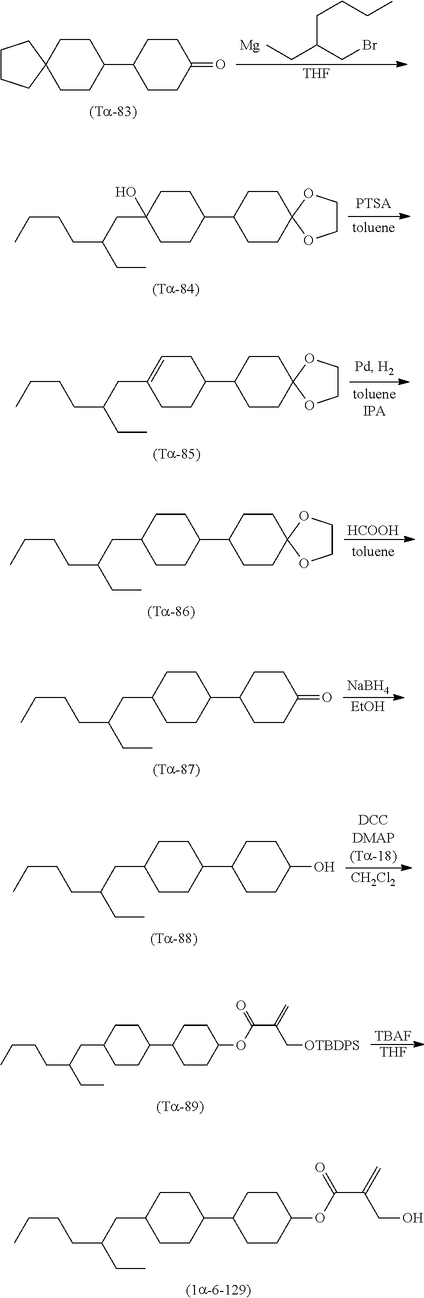

### First Step

Magnesium (turnings) (3.67 g) and THF (50 mL) were put in a reaction vessel, a THF (50 mL) solution of l-bromo-2-hexaethylene (29.1 g) was slowly added dropwise thereto, and the resulting mixture was stirred at 30° C. for 1 hour. A THF (100 mL) solution of compound (Tα-83) (30.0 g) was slowly added dropwise thereto, and the resulting mixture was stirred at room temperature for 6 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=4:1 in a volume ratio) to obtain compound (Tα-84) (8.88 g; 20%).

### Second Step

Compound (Tα-84) (8.88 g), p-toluenesulfonic acid monohydrate (0.47 g), ethylene glycol (1.87 g) and toluene (200 mL) were put in a reaction vessel, and the resulting mixture was stirred at 90° C. for 5 hours. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-85) (8.00 g; 95%).

### Third Step

Compound (Tα-85) (8.00 g), Pd/C (0.12 g), IPA (200 mL) and toluene (200 mL) were put in a reaction vessel, and the resulting mixture was stirred at room temperature for 14 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-86) (7.48 g; 93%).

### Fourth Step

Compound (Tα-87) (5.72 g; 88%) was obtained by using compound (Tα-86) (7.48 g) as a raw material in a manner similar to the technique in the fifth step in Synthesis Example 14α.

### Fifth Step

Sodium borohydride (0.45 g) and ethanol (50 mL) were put in a reaction vessel, and the resulting mixture was cooled down to 0° C. An ethanol (50 mL) solution of compound (Tα-87) (5.72 g) was slowly added dropwise thereto, and the resulting mixture was stirred for 6 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tα-88) (2.65 g; 46%).

### Sixth Step

Compound (Tα-89) (3.72 g; 67%) was obtained by using compound (Tα-88) (2.65 g) as a raw material in a manner similar to the technique in the third step in Synthesis Example 6α.

### Seventh Step

Compound (1α-6-129) (1.60 g; 70%) was obtained by using compound (Tα-89) (3.72 g) as a raw material in a manner similar to the technique in the fourth step in Synthesis Example 6α.

An NMR analysis value of the resulting compound (1α-6-129) was as described below.

¹H-NMR: chemical shift δ (ppm; CDCl₃): 6.22 (s, 1H), 5.79 (d, J=1.0 Hz, 1H), 4.77-4.71 (m, 1H), 4.31 (d, J=6.5 Hz, 2H), 2.31 (d, J=6.7 Hz, 1H), 2.04-2.01 (m, 2H), 1.80-1.68 (m, 6H), 1.39-0.92 (m, 20H), 0.90-0.80 (m, 8H).

Physical properties of compound (1α-6-129) were as described below.

Transition temperature: C<−50.0 I.

### Synthesis Example 23α: Synthesis of Compound (1α-5-53)

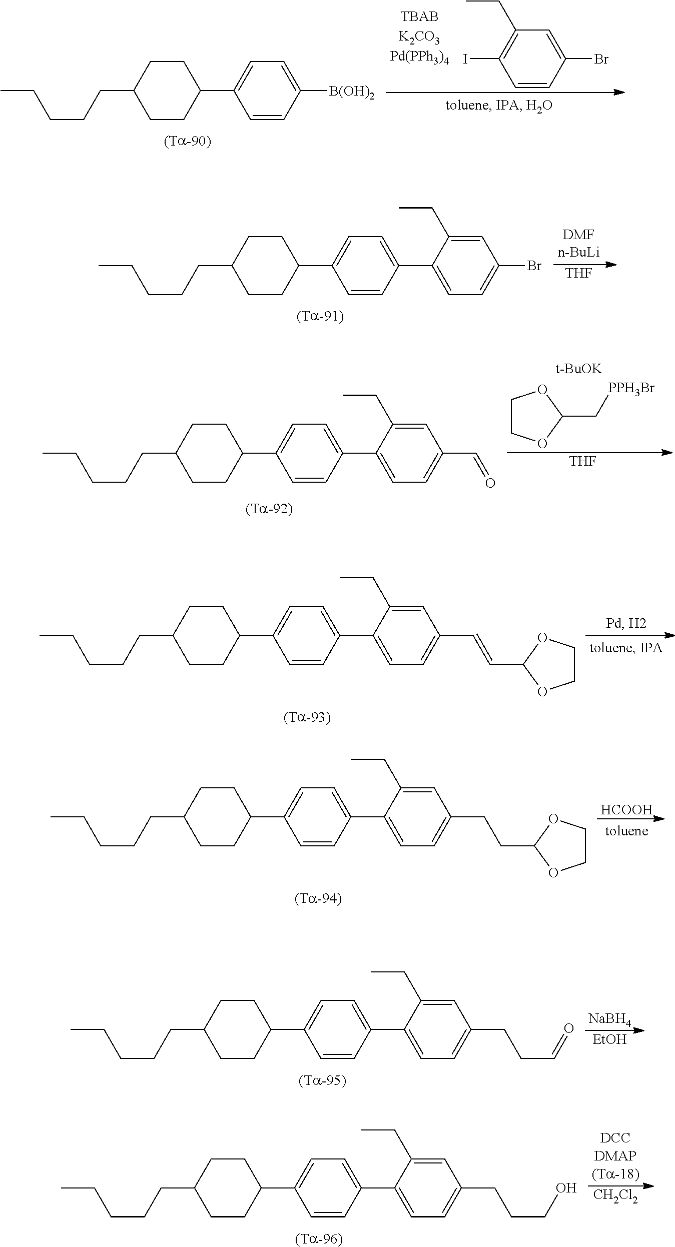

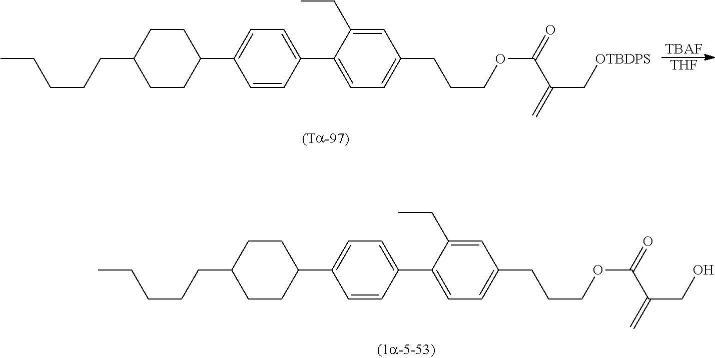

### First Step

Compound (Tα-90) (21.1 g), tetrakis(triphenylphosphine)palladium (0.74 g), potassium carbonate (17.7 g), tetrabutylammonium bromide (8.3 g), 4-bromo-2-ethyl-1-iodobenzene (20.0 g), toluene (200 mL), IPA (150 mL) and H2O (50 mL) were put in a reaction vessel, and the resulting mixture was stirred at 80° C. for 6 hours. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (heptane:toluene=4:1 in a volume ratio) to obtain compound (Tα-91) (22.6 g; 85%).

### Second Step

Compound (Tα-91) (22.6 g) and THF (200 mL) were put in a reaction vessel, the resulting mixture was cooled down to −70° C., and butyllithium (1.60 M; hexane solution; 41 mL) was slowly added dropwise thereto, and the resulting mixture was stirred at −70° C. for 1 hour. DMF (6.35 mL) was slowly added dropwise thereto, and the resulting mixture was stirred for 12 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-92) (16.1 g; 81%).

### Third Step

Then, (1,3-dioxolan-2-yl)methyltriphenylphosphonium bromide (22.8 g) and THF (200 mL) were put in a reaction vessel, and the resulting mixture was cooled down to −30° C. Potassium t-butoxide (5.90 g) was added thereto, and the resulting mixture was stirred at −30° C. for 1 hour. Compound (Tα-92) (16.1 g) was added thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tα-93) (16.5 g; 86%).

### Fourth Step

Compound (Tα-94) (14.9 g; 90%) was obtained by using compound (Tα-93) (16.5 g) as a raw material in a manner similar to the technique in the second step in Synthesis Example 12α.

### Fifth Step

Compound (Tα-95) (11.7 g; 88%) was obtained by using compound (Tα-94) (14.9 g) as a raw material in a manner similar to the technique in the third step in Synthesis Example 12α.

### Sixth Step

Compound (Tα-96) (9.41 g; 80%) was obtained by using compound (Tα-95) (11.7 g) as a raw material in a manner similar to the technique in the fourth step in Synthesis Example 12α.

### Seventh Step

Compound (Tα-97) (6.37 g; 70%) was obtained by using compound (Tα-96) (5.00 g) as a raw material in a manner similar to the technique in the third step in Synthesis Example 6α.

### Eighth Step

Compound (1α-5-53) (3.40 g; 80%) was obtained by using compound (Tα-97) (6.37 g) as a raw material in a manner similar to the technique in the fourth step in Synthesis Example 6α.

An NMR analysis value of the resulting compound (1α-5-53) was as described below.

¹H-NMR: chemical shift δ (ppm; CDCl₃): 7.23-7.19 (m, 4H), 7.13-7.10 (m, 2H), 7.05-7.03 (m, 1H), 6.25 (s, 1H), 5.84 (d, J=1.1 Hz, 1H), 4.33 (d, J=6.7 Hz, 2H), 4.25 (t, J=6.6 Hz, 2H), 2.74 (t, J=7.3 Hz, 2H), 2.58 (q, J=7.5 Hz, 2H), 2.50 (tt, J=12.1 Hz, J=3.3 Hz, 1H), 2.22 (t, J=6.7 Hz, 1H), 2.10-2.04 (m, 2H), 1.96-1.87 (m, 4H), 1.52-1.44 (m, 2H), 1.33-1.21 (m, 9H), 1.11-1.02 (m, 5H), 0.90 (t, J=6.9 Hz, 3H).

Physical properties of compound (1α-5-53) were as described below.

Transition temperature: C 40.0 I.

### Synthesis Example 24α: Synthesis of Compound (1α-6-130)

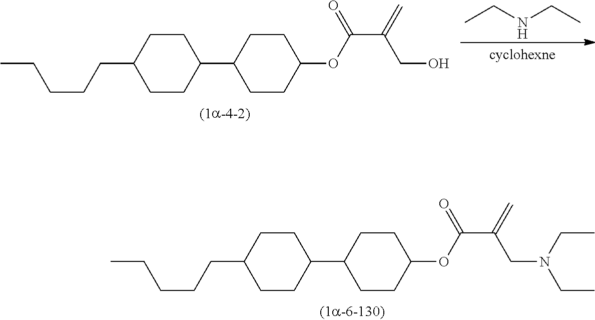

Compound (1α-4-2) (3.00 g), diethylamine (1.30 g) and cyclohexane (100 mL) were put in a reaction vessel, and the resulting mixture was stirred at 75° C. for 12 hours. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio) to obtain compound (1α-6-130) (0.52 g; 15%).

An NMR analysis value of the resulting compound (1α-6-130) was as described below.

¹H-NMR: chemical shift δ (ppm; CDCl₃): 6.18 (s, 1H), 5.74 (s, 1H), 4.74-4.67 (m, 1H), 3.23 (s, 2H), 2.50 (g, J=7.1 Hz, 4H), 2.03-2.01 (m, 2H), 1.78-1.68 (m, 6H), 1.37-0.80 (m, 28H).

Physical properties of compound (1α-6-130) were as described below.

Transition temperature: C 14.1 S_{A} 58.9 I.

Synthesis Example: Synthesis of comparative compound (S-1) Compound (S-1) was prepared as a comparative compound, and characteristics were measured. The reason is that the compound is described in WO 2014/090362 A, and similar to the compound of the invention.

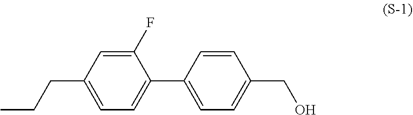 [SMILES: CCCc1ccc(-c2ccc(CO)cc2)c(F)c1]

An NMR analysis value of the resulting comparative compound (S-1) was as described below.

¹H-NMR: chemical shift δ (ppm; CDCl₃): 7.57-7.52 (m, 2H), 7.45-7.42 (m, 2H), 7.36-7.30 (m, 1H), 7.04-6.95 (m, 2H), 4.75 (d, 6.0 Hz, 2H), 2.62 (t, J=7.8 Hz, 2H), 1.75-1.64 (m, 3H), 0.98 (t, J=7.4 Hz, 3H).

### 3. Example 1, Comparative Example 1

Comparison was made on vertical alignability and a voltage holding ratio (VHR) between compound (1α-4-22) and comparative compound (S-1). In addition, composition (i) and polymerizable compound (M-1-1) were used for evaluation.

A proportion of a component of composition (i) was expressed in terms of % by weight.

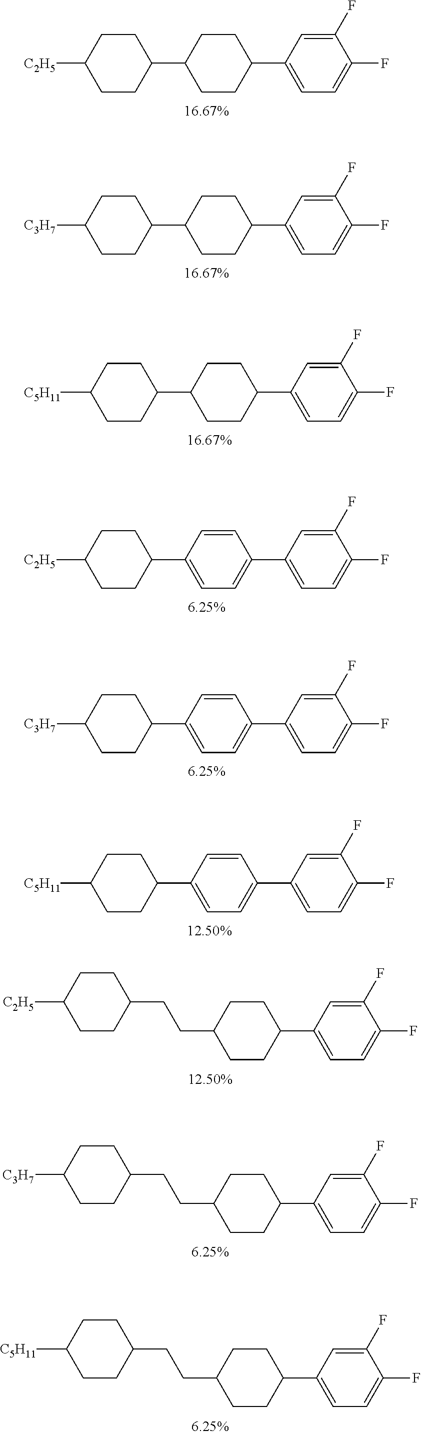

Polymerizable compound (M-1-1) is shown below.

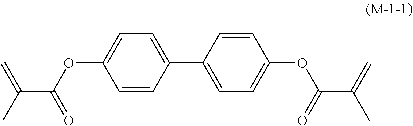 [SMILES: C=C(C)C(=O)Oc1ccc(-c2ccc(OC(=O)C(=C)C)cc2)cc1]

Vertical Alignability

Polymerizable compound (M-1-1) was added to composition (i) in a proportion of 0.4% by weight. Compound (1α-4-22) or comparative compound (S-1) was added thereto in a proportion of 3.5% by weight. The resulting mixture was injected into a device having no alignment film in which a distance (cell gap) between two glass substrates was 3.5 micrometers, which were applied as Example 1 and Comparative Example 1. The device was set to a polarizing microscope, and irradiated with light from below, and presence or absence of light leakage was observed. When liquid crystal molecules were sufficiently aligned and no light passed through the device, the vertical alignability was judged to be “Good.” When light passing through the device was observed, the vertical alignability was represented as “Poor.”

Voltage Holding Ratio (VHR)

The polymerizable compound was polymerized by irradiating the device prepared as described above with ultraviolet light (30 J) using a black light, F40T10/BL (peak wavelength of 369 nm) made by EYE GRAPHICS CO., LTD. The device was charged by applying a pulse voltage (60 microseconds at 1 V) at 60° C. A decaying voltage was measured for 1.67 seconds with a high-speed voltmeter, and area A between a voltage curve and a horizontal axis in a unit cycle was determined. Area B is an area without decay. A voltage holding ratio is expressed in terms of a percentage of area A to area B.

TABLE 2
Table 2: Physical properties of compound
(1α-4-22) and comparative compound (S-1)

| | Example 1 | Comparative Example 1 |
|---|---|---|
| | Compound | Comparative compound |
| | (1α-4-22) | (S-1) |
| Vertical alignability | Good | Good |
| Voltage holding ratio | 80.30% | 23.79% |
| (VHR) | | |

Physical properties of compound (1α-4-22) in Synthesis Example 2α and comparative compound (S-1) are summarized in Table 2. Both the compounds exhibited good vertical alignability in the device having no alignment film. On the other hand, the voltage holding ratio in use of compound (1α-4-22) was higher than the voltage holding ratio in use of comparative compound (S-1). The reason is that a polar compound having a —OH group as in comparative compound (S-1) significantly reduces the voltage holding ratio of the device, but the compound is provided with polymerizability as in compound (1α-4-22), and the polar compound was incorporated into the polymer formed of the polymerizable compound to suppress reduction of the voltage holding ratio. Accordingly, compound (1α-4-22) is reasonably a superior compound exhibiting the good vertical alignability without reducing the voltage holding ratio of the device.

### 4. Example 2, Example 3, Comparative Example 2

Comparison of a voltage holding ratio (VHR) was made on compound (1α-4-2) and comparative compound (S-1). In addition, composition (ii) and polymerizable compound (M-1-3) were used for evaluation.

The compounds in the composition were represented using symbols according to definitions in Table 3 described below. In Table 3, the configuration of 1,4-cyclohexylene is trans. A parenthesized number next to a symbolized compound corresponds to the number of the compound. A symbol (-) means any other liquid crystal compound. A proportion (percentage) of the liquid crystal compound is expressed in terms of weight percent (% by weight) based on the weight of the liquid crystal composition. Values of the characteristics of the liquid crystal composition were summarized in the last part. The characteristics were measured according to the methods described above, and measured values are directly described (without extrapolation).

TABLE 3
Table 3 Method for description of compounds using symbols
R—(A₁)—Z_{1 ·} _{·} _{·} —Zₙ—(Aₙ)—R′

| | Symbol |
|---|---|
| 1) Left-terminal group R— | |
| CₙH₂ₙ₊₁— | n- |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| 2) Right-terminal group —R′ | |
| —CₙH₂ₙ₊₁ | -n |
| —OCₙH₂ₙ₊₁ | —On |
| —COOCH₃ | —EMe |
| —CH═CH₂ | —V |
| —CH═CH—CₙH₂ₙ₊₁ | —Vn |
| —CₙH₂ₙ—CH═CH₂ | —nV |
| —CₘH₂ₘ—CH═CH—CₙH₂ₙ₊₁ | —mVn |
| —CH═CF₂ | —VFF |
| —F | —F |
| —Cl | —CL |
| —OCF₃ | —OCF3 |
| —OCF₂H | —OCF2H |
| —CF₃ | —CF3 |
| —OCH═CH—CF₃ | —OVCF3 |
| —C≡N | —C |
| 3) Bonding group —Zₙ— | |
| —CₙH₂ₙ— | n |
| —COO— | E |
| —CH═CH— | V |
| —CH₂O— | 1O |
| —OCH_{2—} | O1 |
| —CF₂O— | X |
| —C≡C— | T |
| 4) Ring structure —Aₙ— | |
| 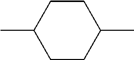 | H |
| 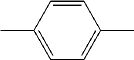 | B |
| 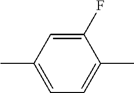 | B(F) |
| 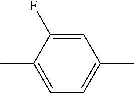 | B(2F) |
| 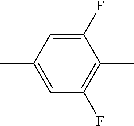 | B(F,F) |
| 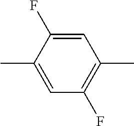 | B(2F,5F) |
| 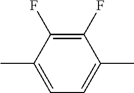 | B(2F,3F) |
| 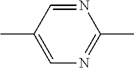 | Py |
| 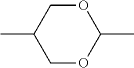 | G |
| 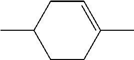 | ch |

5) Examples of description
Example 1 3-HB-CL

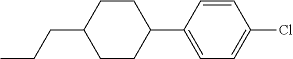 [SMILES: CCCC1CCC(c2ccc(Cl)cc2)CC1]

Example 2 5-HHBB(F,F)-F

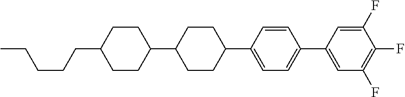 [SMILES: CCCCCC1CCC(C2CCC(c3ccc(-c4cc(F)c(F)c(F)c4)cc3)CC2)CC1]

Example 3 3-HB-02

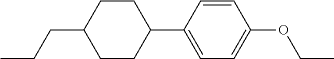 [SMILES: CCCC1CCC(c2ccc(OCC)cc2)CC1]

Example 4 3-HBB(F,F)-F

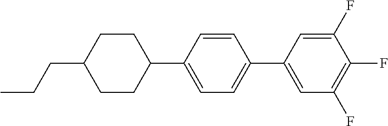 [SMILES: CCCC1CCC(c2ccc(-c3cc(F)c(F)c(F)c3)cc2)CC1]

A proportion of a component of composition (ii) was expressed in terms of % by weight.

| | | |
|---|---|---|
| 3-HB(2F,3F)-O2 | (2-1) | 18% |
| 3-HHB(2F,3F)-O2 | (2-6) | 9% |
| 2-HBB(2F,3F)-O2 | (2-10) | 6% |
| 3-HBB(2F,3F)-O2 | (2-10) | 10% |
| 4-HBB(2F,3F)-O2 | (2-10) | 8% |
| 2-HH-3 | (3-1) | 25% |
| 3-HH-4 | (3-1) | 10% |
| 1-BB-3 | (3-3) | 5% |
| 3-HBB-2 | (3-6) | 9% |

NI=76.1° C.; η=16.1 mPa·s; Δn=0.100; Δε=−2.5; Vth=2.4 V.

### Example 2

Compound (1α-4-2) was added to composition (ii) in a proportion of 3% by weight.

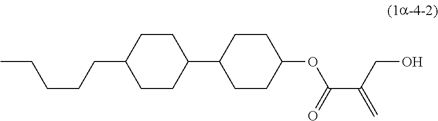 [SMILES: C=C(CO)C(=O)OC1CCC(C2CCC(CCCCC)CC2)CC1]

Compound (M-1-3) was further added thereto in a proportion of 0.3% by weight. The composition was injected into a device having no alignment film in which a distance (cell gap) between two glass substrates was 3.5 micrometers to prepare a device, and the polymerizable compound was polymerized by irradiating the device prepared as described above with ultraviolet light (40 J) using a black light, F40T10/BL (peak wavelength of 369 nm) made by EYE GRAPHICS CO., LTD, which was applied as Example 2.

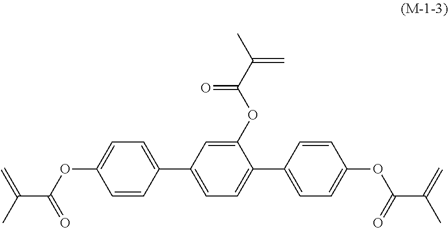 [SMILES: C=C(C)C(=O)Oc1ccc(-c2ccc(-c3ccc(OC(=O)C(=C)C)cc3)c(OC(=O)C(=C)C)c2)cc1]

### Example 3

Compound (1α-4-2) was added to composition (ii) in a proportion of 3% by weight. The composition was injected into a device having no alignment film in which a distance (cell gap) between two glass substrates was 3.5 micrometers to prepare a device, and the polymerizable compound was polymerized by irradiating the device prepared as described above with ultraviolet light (60 J) using a black light, F40T10/BL (peak wavelength of 369 nm) made by EYE GRAPHICS CO., LTD, which was applied as Example 3.

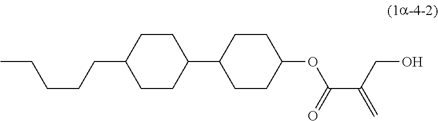 [SMILES: C=C(CO)C(=O)OC1CCC(C2CCC(CCCCC)CC2)CC1]

### Comparative Example 2

Comparative compound (S-1) used in Comparative Example 1 was added to composition (ii) in a proportion of 3.5% by weight. Compound (M-1-3) was further added thereto in a proportion of 0.4% by weight. The composition was injected into a device having no alignment film in which a distance (cell gap) between two glass substrates was 3.5 micrometers to prepare a device, and the polymerizable compound was polymerized by irradiating the device prepared as described above with ultraviolet light (40 J) using a black light, F40T10/BL (peak wavelength of 369 nm) made by EYE GRAPHICS CO., LTD, which was applied as Comparative Example 2.

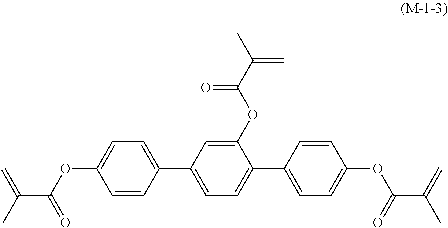 [SMILES: C=C(C)C(=O)Oc1ccc(-c2ccc(-c3ccc(OC(=O)C(=C)C)cc3)c(OC(=O)C(=C)C)c2)cc1]

A voltage holding ratio (VHR) of each device in Examples 2 to 3 and Comparative Example 2 was measured.

TABLE 4
Table 4: Voltage holding ratio (VHR)

| | Liquid | Polar compound | | Polymerizable compound | | | | |
|---|---|---|---|---|---|---|---|---|
| | crystal | | Amount of | | Amount of | VHR/1 V, 0.3 Hz 60° C. (%) | | |
| | composition | Compound | addition | Compound | addition | 0 h | 250 h | 500 hr |
| Example 2 | Composition | 1α-4-2 | 3 wt % | M-1-3 | 0.3 wt % | 96.3 | 95.8 | 94.9 |
| | (ii) | | | | | | | |
| Example 3 | Composition | 1α-4-2 | 3 wt % | — | — | 93.7 | 92.4 | 90.2 |
| | (ii) | | | | | | | |
| Comparative | Composition | S-1 | 3.5 wt % | M-1-3 | 0.4 wt % | 72.9 | — | — |
| Example 2 | (ii) | | | | | | | |

The voltage holding ratio in use of compound (1α-4-2) was higher than the voltage holding ratio in use of comparative compound (S-1) in Comparative Example 2. The reason is that a polar compound having a —OH group as in comparative compound (S-1) significantly reduced the voltage holding ratio of the device, but in the polymerizable polar compound as in compound (1α-4-2), the polar compound was incorporated into the polymer formed to suppress reduction of the voltage holding ratio. Accordingly, compound (1α-4-2) is reasonably a superior compound without reducing the voltage holding ratio of the device.

Moreover, in each device in Examples 2 and 3, when the voltage holding ratio after the device was allowed to be left on the backlight for a predetermined period of time was measured, a high value thereof was maintained as shown in Table 4.

### 5. Synthesis Example of Compound (1β)

### Synthesis Example 1β: Synthesis of Compound (1β-4-3)

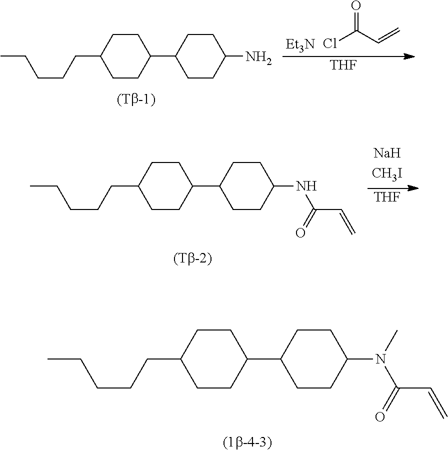

### First Step

Compound (Tβ-1) (25.0 g), triethylamine (16.65 mL) and THF (300 mL) were put in a reaction vessel, and the resulting mixture was cooled down to 0° C. Acrylic chloride (9.7 mL) was slowly added dropwise thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tβ-2) (16.4 g; 54%).

### Second Step

Sodium hydride (2.57 g) and THF (300 mL) were put in a reaction vessel, and the resulting mixture was cooled down to 0° C. A THF solution (100 mL) solution of compound (Tβ-2) (16.4 g) was slowly added dropwise thereto, and the resulting mixture was stirred for 1 hour. Methyl iodide (3.7 mL) was slowly added dropwise thereto, and the resulting mixture was stirred for 3 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=4:1 in a volume ratio). The residue was further purified by recrystallization from heptane to obtain compound (1β-4-3) (14.2 g; 83%).

An NMR analysis value of the resulting compound (1β-4-3) was as described below.

¹H-NMR: chemical shift δ (ppm; CDCl₃): 6.56 (m, 1H), 6.27 (t, 1H), 5.65 (t, 1H), 4.45 (m, 1H), 2.90 (s, 3H), 1.83-1.52 (m, 8H), 1.43-1.20 (m, 8H), 1.18-0.92 (m, 9H), 0.89-0.80 (m, 5H).

Physical properties of compound (1β-4-3) were as described below.

Transition temperature: C 56.9 I.

### Synthesis Example 2β: Synthesis of Compound (1β-4-45)

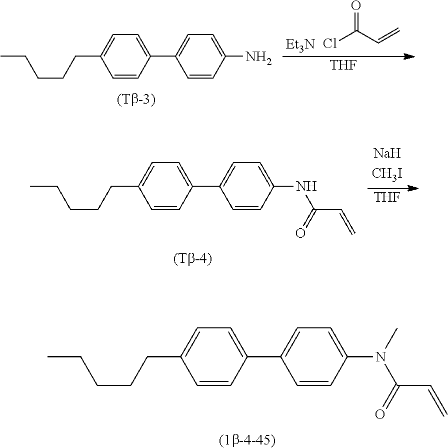

### First Step

Compound (Tβ-3) (25.0 g), triethylamine (16.0 mL) and THF (300 mL) were put in a reaction vessel, and the resulting mixture was cooled down to 0° C. Acrylic chloride (9.28 mL) was slowly added dropwise thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tβ-4) (15.6 g; 51%).

### Second Step

Sodium hydride (2.55 g) and THF (300 mL) were put in a reaction vessel, and the resulting mixture was cooled down to 0° C. A THF solution (100 mL) solution of compound (Tβ-4) (15.6 g) was slowly added dropwise thereto, and the resulting mixture was stirred for 1 hour. Methyl iodide (3.6 mL) was slowly added dropwise thereto, and the resulting mixture was stirred for 3 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=4:1 in a volume ratio). The residue was further purified by recrystallization from heptane to obtain compound (1β-4-45) (13.0 g; 80%).

An NMR analysis value of the resulting compound (1β-4-45) was as described below.

¹H-NMR: chemical shift δ (ppm; CDCl₃): 7.51 (m, 4H), 7.23 (m, 4H), 6.54 (m, 1H), 6.25 (t, 1H), 5.63 (t, 1H), 2.95 (s, 3H), 2.62 (t, 2H), 1.67-1.62 (m, 2H), 1.37-1.33 (m, 4H), 0.90 (s, 3H).

Physical properties of compound (1β-4-45) were as described below.

Transition temperature: C 58.0 I.

### 6. Example 11, Comparative Example 11

Comparison was made on vertical alignability and a voltage holding ratio (VHR) between compound (1β-4-3) and comparative compound (S-1). Composition (i) and polymerizable compound (M-1-1) were used for evaluation. In addition, comparative compound (S-1), composition (i) and polymerizable compound (M-1-1) are identical thereto used in Example 1.

Vertical Alignability

Polymerizable compound (M-1-1) was added to composition (i) in a proportion of 0.4% by weight. Compound (1β-4-3) or comparative compound (S-1) was added thereto in a proportion of 3.0% by weight. The resulting mixture was injected into a device having no alignment film in which a distance (cell gap) between two glass substrates was 3.5 micrometers, which were applied as Example 11 and Comparative Example 11. The device was set to a polarizing microscope, and irradiated with light from below, and presence or absence of light leakage was observed. When liquid crystal molecules were sufficiently aligned and no light passed through the device, the vertical alignability was judged to be “Good.” When light passing through the device was observed, the vertical alignability was represented as “Poor.”

Voltage Holding Ratio (VHR)

The device prepared as described above was charged by applying a pulse voltage (60 microseconds at 1 V) at 60° C. A decaying voltage was measured for 0.0167 second with a high-speed voltmeter, and area A between a voltage curve and a horizontal axis in a unit cycle was determined. Area B is an area without decay. A voltage holding ratio is expressed in terms of a percentage of area A to area B.

TABLE 5
Table 5: Physical properties of compound
(1β-4-3) and comparative compound (S-1)

| | Example 11 | Comparative Example 11 |
|---|---|---|
| | Compound | Comparative compound |
| | (1β-4-3) | (S-1) |
| Vertical alignability | Good | Good |
| Voltage holding ratio | 95.2% | 47.7% |
| (VHR) | | |

Physical properties of compound (1β-4-3) in Synthesis Example 1β and comparative compound (S-1) are summarized in Table 5. Both the compounds exhibited good vertical alignability in the device having no alignment film. On the other hand, the voltage holding ratio in use of compound (1β-4-3) was higher than the voltage holding ratio in use of comparative compound (S-1). The reason is that a polar compound having a —OH group as in comparative compound (S-1) significantly reduces the voltage holding ratio of the device, but an acrylamide group causes no reduction of the voltage holding ratio. Accordingly, compound (1β-4-3) is reasonably a superior compound exhibiting the good vertical alignability without reducing the voltage holding ratio of the device.

### 7. Examples 12 to 13, Comparative Example 12

Examples as the device will be described below.

### Raw Material

A composition to which a polar compound having a (meth)acrylamide group represented by formula (1β) was added was injected into a device having no alignment film. After the device was irradiated with ultraviolet light, vertical alignment of liquid crystal molecules in the device was examined. A raw material will be described first. As the raw material, compositions (iii) and (iv), polar compound (1β-4-3) having the (meth)acrylamide group and polymerizable compound (M-1-1) were used.

A proportion of a component of composition (iii) was expressed in terms of % by weight.

| | | |
|---|---|---|
| 3-HB(2F,3F)-O2 | (2-1) | 10% |
| 5-HB(2F,3F)-O2 | (2-1) | 7% |
| 2-BB(2F,3F)-O2 | (2-4) | 7% |
| 3-BB(2F,3F)-O2 | (2-4) | 7% |
| 3-B(2F,3F)B(2F,3F)-O2 | (2-5) | 3% |
| 2-HHB(2F,3F)-O2 | (2-6) | 5% |
| 3-HHB(2F,3F)-O2 | (2-6) | 10% |
| 2-HBB(2F,3F)-O2 | (2-10) | 8% |
| 3-HBB(2F,3F)-O2 | (2-10) | 10% |
| 2-HH-3 | (3-1) | 14% |
| 3-HB-O1 | (3-2) | 5% |
| 3-HHB-1 | (3-5) | 3% |
| 3-HHB-O1 | (3-5) | 3% |
| 3-HHB-3 | (3-5) | 4% |
| 2-BB(F)B-3 | (3-8) | 4% |

NI=73.2° C.; Tc<−20° C.; Δn=0.113; Δε=−4.0; Vth=2.18 V; g=22.6 mPa·s.

A proportion of a component of composition (iv) was expressed in terms of % by weight.

| | | |
|---|---|---|
| V-HB(2F,3F)-O2 | (2-1) | 10% |
| V2-HB(2F,3F)-O2 | (2-1) | 10% |
| 2-H1OB(2F,3F)-O2 | (2-3) | 3% |
| 3-H1OB(2F,3F)-O2 | (2-3) | 3% |
| 2O-BB(2F,3F)-O2 | (2-4) | 3% |
| V2-BB(2F,3F)-O2 | (2-4) | 8% |
| V2-HHB(2F,3F)-O2 | (2-6) | 5% |
| 2-HBB(2F,3F)-O2 | (2-10) | 3% |
| 3-HBB(2F,3F)-O2 | (2-10) | 3% |
| V-HBB(2F,3F)-O2 | (2-10) | 6% |
| V-HBB(2F,3F)-O4 | (2-10) | 8% |
| V-HHB(2F,3Cl)-O2 | (2-12) | 7% |
| 3-HH-4 | (3-1) | 14% |
| V-HHB-1 | (3-5) | 10% |
| 3-HBB-2 | (3-6) | 7% |

NI=75.9° C.; Tc<−20° C.; Δn=0.114; Δε=−3.9; Vth=2.20 V; g=24.7 mPa·s.

The alignable monomer is polar compound (1β-4-3) having a (meth)acrylamide group. In addition, when the monomer has hydrogen directly bonded with nitrogen, more specifically, only when M¹ in formula (1β) is hydrogen, in order to define a structure of the (meth)acrylamide group, NH was designated in a structural formula.

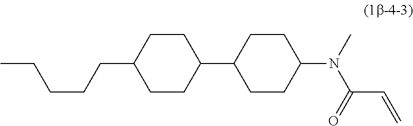 [SMILES: C=CC(=O)N(C)C1CCC(C2CCC(CCCCC)CC2)CC1]

The polymerizable compound is polymerizable compound (M-1-1).

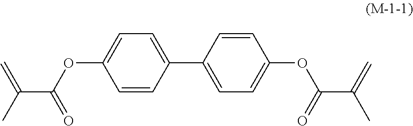 [SMILES: C=C(C)C(=O)Oc1ccc(-c2ccc(OC(=O)C(=C)C)cc2)cc1]

### Vertical Alignment of Liquid Crystal Molecules

### Example 12

Polar compound (1β-4-3) having a (meth) acrylamide group was added to composition (iii) in a proportion of 5% by weight. The resulting mixture was injected, on a hot stage at 100° C., into a device having no alignment film in which a distance (cell gap) between two glass substrates was 4.0 micrometers. Polar compound (1β-4-3) having the (meth)acrylamide group was polymerized by irradiating the device with ultraviolet light (28J) using an ultra-high pressure mercury lamp USH-250-BY (made by Ushio, Inc.). The device was set to a polarizing microscope in which a polarizer and an analyzer were orthogonally arranged, and irradiated with light from below, and presence or absence of light leakage was observed. When liquid crystal molecules were sufficiently aligned and no light passed through the device, the vertical alignment was judged to be “Good.” When light passing through the device was observed, the vertical alignment was represented as “Poor.”

### Example 13, Comparative Example 12

In Example 13, a device having no alignment film was prepared by using a mixture prepared by adding a polar compound having a (meth)acrylamide group to a composition. Presence or absence of light leakage was observed in a manner similar to Example 12. The results are summarized in the table. In Example 13, polymerizable compound (M-1-1) was also added in a proportion of 0.5% by weight. In Comparative Example 12, polar compound (S-1) was selected for comparison. The reason is that the compound has no polymerizable group, and therefore is different from compound (1β).

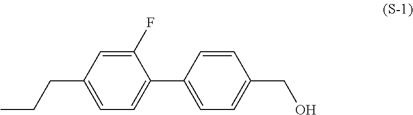 [SMILES: CCCc1ccc(-c2ccc(CO)cc2)c(F)c1]

TABLE 6
Table 6: Vertical alignability of molecules

| | | Polar | Polymerizable | |
|---|---|---|---|---|
| | | compound | compound | |
| | Liquid crystal | (5% by | (0.5% by | Vertical |
| | composition | weight) | weight) | alignment |
| Example 12 | Composition | 1β-4-3 | — | Good |
| | (iii) | | | |
| Example 13 | Composition | 1β-4-3 | M-1-1 | Good |
| | (iv) | | | |
| Comparative | Composition | S-1 | — | Poor |
| Example 12 | (iii) | | | |

### 8. Synthesis Example of Compound (1γ)

### Synthesis Example 1γ: Synthesis of Compound (1γ-2-7)

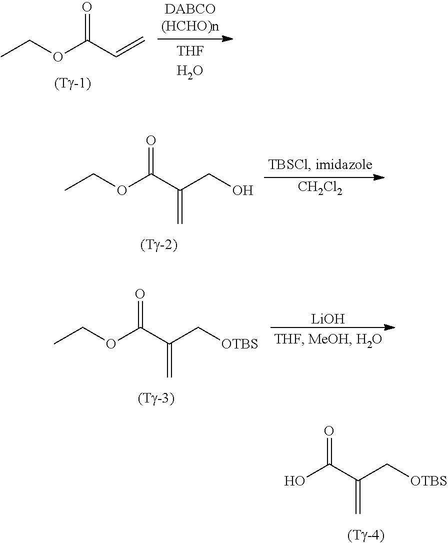

### First Step

Paraformaldehyde (60.0 g), DABCO (56.0 g) and water (200 mL) were put in a reaction vessel, and the resulting mixture was stirred at room temperature for 15 minutes. A THF (40 mL) solution of compound (Tγ-1) (50.0 g) was added dropwise thereto, and the resulting mixture was stirred at room temperature for 72 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=2:1 in a volume ratio) to obtain compound (Tγ-2) (44.1 g; 68%).

### Second Step

Compound (Tγ-2) (44.1 g), imidazole (25.0 g) and dichloromethane (400 mL) were put in a reaction vessel, and the resulting mixture was cooled down to 0° C. A dichloromethane solution (200 mL) of t-butyldimethylchlorosilane (53 g) was added dropwise thereto, and the resulting mixture was stirred for 4 hours while raising temperature to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=9:1 in a volume ratio) to obtain compound (Tγ-3) (105 g; 84%).

### Third Step

Compound (Tγ-3) (105 g), THF (600 mL), methanol (150 mL) and water (100 mL) were put in a reaction vessel, and the resulting mixture was cooled down to 0° C. Lithium hydroxide monohydrate (17.4 g) was added thereto, and the resulting mixture was stirred for 12 hours while returning to room temperature. The resulting reaction mixture was poured into water, and 6 N hydrochloric acid (20 mL) was slowly added thereto to acidify the resulting mixture, and then an aqueous layer was subjected to extraction with ethyl acetate. A combined organic layer was washed with water and dried over anhydrous magnesium sulfate. The solution was concentrated under reduced pressure to obtain compound (Tγ-4) (34.0 g; 35%).

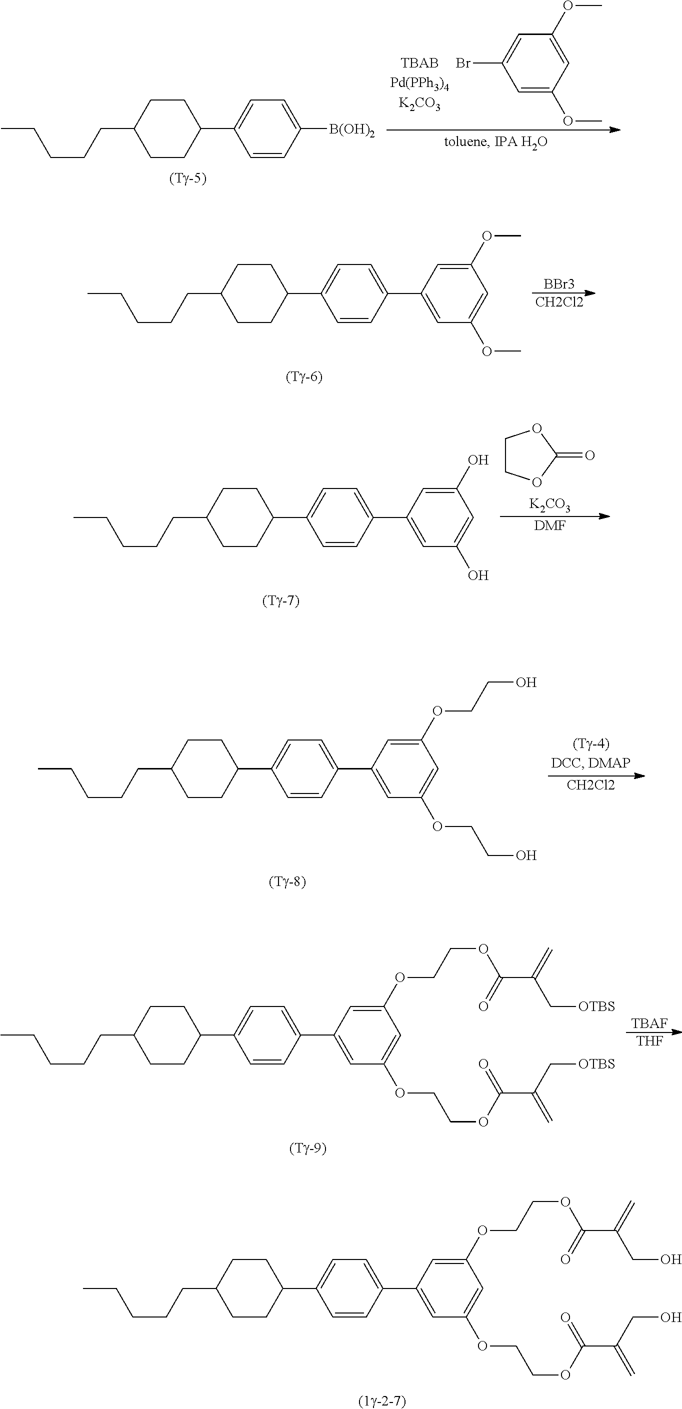

### Fourth Step

Compound (Tγ-5) (7.5 g), tetrakis(triphenylphosphine)palladium (1.3 g), TBAB (tetrabutylammonium bromide) (1.5 g), potassium carbonate (6.4 g), l-bromo-3,5-dimethoxybenzene (5 g), toluene (200 mL), IPA (2-propanol) (80 mL) and pure water (20 mL) were put in a reaction vessel, and the resulting mixture was stirred at 90° C. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=9:1 in a volume ratio), and further purified by recrystallization from a mixed solvent of heptane and toluene (1:1 in a volume ratio) to obtain compound (Tγ-6) (7.18 g; 85%).

### Fifth Step

Compound (Tγ-6) (7.18 g) and dichloromethane (200 mL) were put in a reaction vessel, and the resulting mixture was cooled down to −50 while being stirred. Boron tribromide (2.1 mL) was added dropwise thereto, and the resulting mixture was stirred for 5 hours while raising temperature to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (toluene:ethyl acetate=1:1 in a volume ratio) to obtain compound (Tγ-7) (5.3 g; 80%).

### Sixth Step

Compound (Tγ-7) (5.3 g), ethylene carbonate (3.0 g), potassium carbonate (6.5 g) and DMF (200 mL) were put in a reaction vessel, and the resulting mixture was stirred at 100° C. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio) to obtain compound (Tγ-8) (5.5 g; 83%).

### Seventh Step

Compound (Tγ-8) (5.3 g), compound (Tγ-4) (5.9 g), DMAP (1.52 g) and dichloromethane (150 mL) were put in a reaction vessel, and the resulting mixture was cooled down to 0° C. while being stirred. A dichloromethane solution (50 mL) of DCC (7.7 g) was added dropwise thereto, and the resulting mixture was stirred for 5 hours while raising temperature to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (toluene:heptane=1:1 in a volume ratio) to obtain compound (Tγ-9) (8.3 g; 81%).

### Eighth Step

Compound (Tγ-9) (8.3 g) and THF (100 mL) were put in a reaction vessel, and the resulting mixture was cooled down to 0° C. while being stirred. TBAF (2.9 g) was added dropwise thereto, and the resulting mixture was stirred for 3 hours while raising temperature to room temperature. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio), and further purified by recrystallization from heptane to obtain compound (1γ-2-7) (4.5 g; 75%).

An NMR analysis value of the resulting compound (1γ-2-7) was as described below.

¹H-NMR: chemical shift δ (ppm; CDCl₃): 7.48-7.46 (m, 2H), 7.27-7.26 (m, 2H), 6.75 (d, J=2.3 Hz, 2H), 6.47-6.46 (m, 1H), 6.30 (s, 2H), 5.86 (d, J=1.1 Hz, 2H), 4.54 (t, J=4.4 Hz, 4H), 4.33 (s, 4H), 4.27-4.25 (m, 4H), 2.52-2.47 (m, 1H), 2.34 (s, 2H), 1.90 (t, J=14 Hz, 4H), 1.51-1.44 (m, 2H), 1.35-1.20 (m, 9H), 1.09-1.02 (m, 2H), 0.90 (t, J=6.9 Hz, 3H).

Physical properties of compound (1γ-2-7) were as described below.

Transition temperature: C 58.8

### Synthesis Example 2γ: Synthesis of Compound (1γ-5-2)

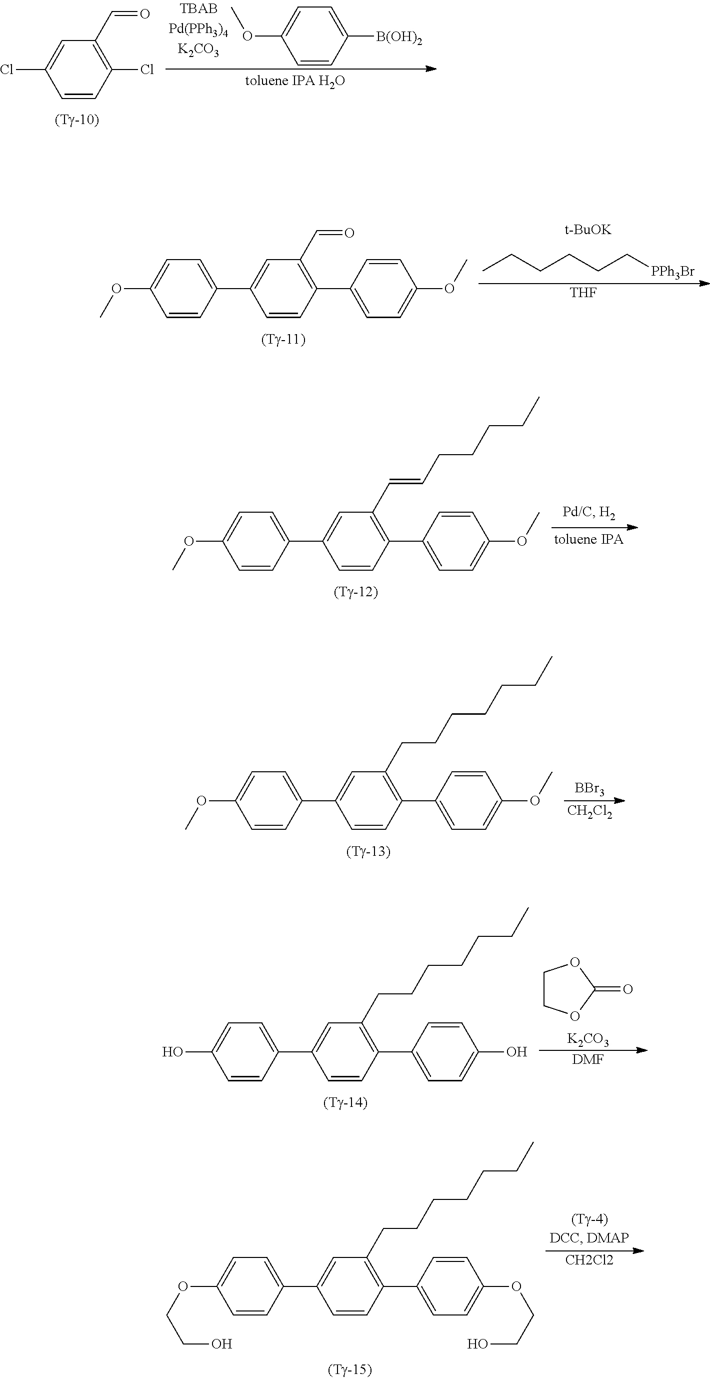

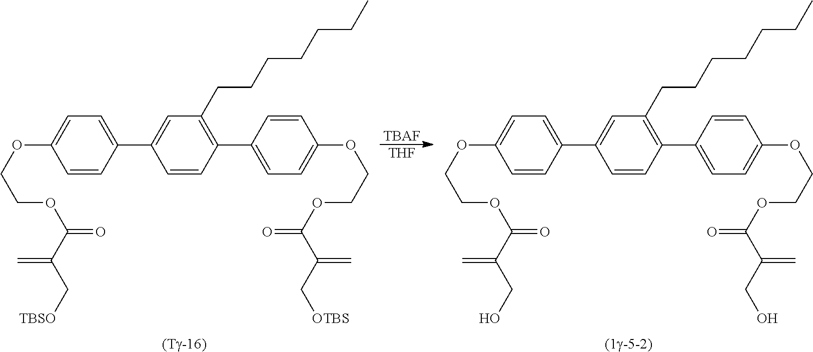

### First Step

Compound (Tγ-10) (10.0 g), 4-methoxyphenylboronic acid (19.1 g), tetrakis(triphenylphosphine)palladium (1.9 g), potassium carbonate (15.8 g), TBAB (3.7 g), toluene (200 mL), IPA (80 mL) and pure water (20 mL) were put in a reaction vessel, and the resulting mixture was stirred at 90° C. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=9:1 in a volume ratio), and further purified by recrystallization from a mixed solvent of heptane and toluene (1:1 in a volume ratio) to obtain compound (Tγ-11) (14.9 g; 82%).

### Second Step

Hexyltriphenylphosphonium bromide (22.0 g) and THF (100 mL) were put in a reaction vessel, and the resulting mixture was stirred while being cooled down to −30° C. Potassium t-butoxide (5.7 g) was added thereto, and the resulting mixture was stirred at −30° C. for 1 hour. A THF solution (100 mL) of compound (Tγ-11) (14.9 g) was added dropwise thereto, and the resulting mixture was stirred for 4 hours while raising temperature to room temperature. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene) to obtain compound (Tγ-12) (16.2 g; 90%).

### Third Step

Compound (Tγ-12) (16.2 g), Pd/C (0.2 g), toluene (100 mL) and IPA (100 mL) were put in a reaction vessel, and the resulting mixture was stirred for 10 hours under a hydrogen atmosphere. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene) to obtain compound (Tγ-13) (15.5 g; 95%).

### Fourth Step

Compound (Tγ-13) (15.5 g) and dichloromethane (200 mL) were put in a reaction vessel, and the resulting mixture was stirred while being cooled down to −50° C. Boron tribromide (22.0 g) was added dropwise thereto, and the resulting mixture was stirred for 5 hours while raising temperature to room temperature. The resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:ethyl acetate=8:2 in a volume ratio) to obtain compound (Tγ-14) (13.0 g; 90%).

### Fifth Step

Compound (Tγ-14) (13.0 g), ethylene carbonate (9.5 g), potassium carbonate (15.0 g) and DMF (200 mL) were put in a reaction vessel, and the resulting mixture was stirred at 100° C. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=8:2 in a volume ratio) to obtain compound (Tγ-15) (13.6 g; 84%).

### Sixth Step

Compound (Tγ-15) (13.6 g), compound (Tγ-4) (14.4 g), DMAP (1.85 g) and dichloromethane (350 mL) were put in a reaction vessel, and the resulting mixture was cooled down to 0° C. while being stirred. A dichloromethane solution (150 mL) of DCC (18.8 g) was added dropwise thereto, and the resulting mixture was stirred for 5 hours while raising temperature to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tγ-16) (19.2 g; 75%).

### Seventh Step

Compound (Tγ-16) (19.2 g) and THF (200 mL) were put in a reaction vessel, and the resulting mixture was cooled down to 0° C. while being stirred. TBAF (6.5 g) was added dropwise thereto, and the resulting mixture was stirred for 3 hours while raising temperature to room temperature. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio), and further purified by recrystallization from heptane to obtain compound (1γ-5-2) (9.8 g; 70%).

An NMR analysis value of the resulting compound (1γ-5-2) was as described below.

¹H-NMR: chemical shift δ (ppm; CDCl₃): 7.65-7.55 (m, 2H), 7.45 (d, J=1.6 Hz, 1H), 7.39 (dd, J=7.8 Hz, J=1.8 Hz, 1H), 7.25-7.22 (m, 3H), 7.13 (d, J=8.6 Hz, 2H), 6.98-6.93 (m, 4H), 6.84 (d, J=8.7 Hz, 2H), 6.29 (s, 1H), 5.85 (d, J=1.2 Hz, 1H), 4.52 (t, J=4.8 Hz, 2H), 4.33 (d, J=6.7 Hz, 2H), 4.21 (t, J=7.8 Hz, J=1.8 Hz, 1H), 6.27 (d, J=3.5 Hz, 2H), 5.85 (s, 1H), 4.35-4.28 (m, 8H), 4.06-4.04 (m, 4H), 2.62 (t, J=7.8 Hz, 2H), 2.30 (s, 2H), 1.93-1.92 (m, 8H), 1.58-1.48 (m, 2H), 1.26-1.17 (m, 8H), 0.84 (t, 6.9 Hz, 3H).

Physical properties of compound (1γ-5-2) were as described below.

Transition temperature: C 44.0 I.

### 9. Example 21, Comparative Example 21

Comparison was made on vertical alignability between compound (1γ-2-7) and comparative compound (S-1). Composition (i) and polymerizable compound (M-1-1) were used for evaluation. In addition, comparative compound (S-1), composition (i) and polymerizable compound (M-1-1) are identical thereto used in Example 1.

Vertical Alignability

Polymerizable compound (M-1-1) was added to composition (i) in a proportion of 0.4% by weight. Compound (1γ-2-7) or comparative compound (S-1) was added thereto in a proportion of 0.5% to 3.0%. The resulting mixture was injected into a device having no alignment film in which a distance (cell gap) between two glass substrates was 3.5 micrometers, which were applied as Example 21 and Comparative Example 21. The device was set to a polarizing microscope, and irradiated with light from below, and presence or absence of light leakage was observed. When liquid crystal molecules were sufficiently aligned and no light passed through the device, the vertical alignability was judged to be “Good.” When light passing through the device was observed, the vertical alignability was represented as “Poor.”

TABLE 7
Table 6: Alignability of compound (1γ-2-7)
and comparative compound (S-1)

| Addition | Example 21 | Comparative Example 21 |
|---|---|---|
| concentration | Compound | Comparative compound |
| (%) | (1γ-2-7) | (S-1) |
| 0.5 | Good | Poor |
| 1.0 | Good | Poor |
| 2.0 | Good | Poor |
| 3.0 | Good | Good |

The vertical alignability of compound (1γ-2-7) and comparative compound (S-1) were summarized in Table 7. In comparative compound (S-1), the vertical alignability was confirmed in 3.0%. On the other hand, when compound (1γ-2-7) was used, the vertical alignability was confirmed in addition of 0.5%, and the good vertical alignability was exhibited at a lower concentration in comparison with comparative compound (S-1). The reason is that the vertical alignability was increased by compound (1γ-2-7) having a plurality of —OH groups to induce vertical alignment. Accordingly, compound (1γ-2-7) is reasonably a superior compound exhibiting the good vertical alignability at a lower concentration.

### 10. Examples 22 to 23, Comparative Example 22

Examples as the device will be described below.

### Raw Material

A composition to which a polar compound was added was injected into a device having no alignment film. After the device was irradiated with ultraviolet light, vertical alignment of liquid crystal molecules in the device was examined. A raw material will be described first. As the raw material, compositions (iii) and (iv), polar compounds (1γ-2-7) and (1γ-5-2) and polymerizable compound (M-1-1) were used. In addition, compositions (iii) and (iv) and polymerizable compound (M-1-1) are identical thereto used in Example 12.

The alignable monomer is polar compounds (1γ-2-7) and (1γ-5-2).

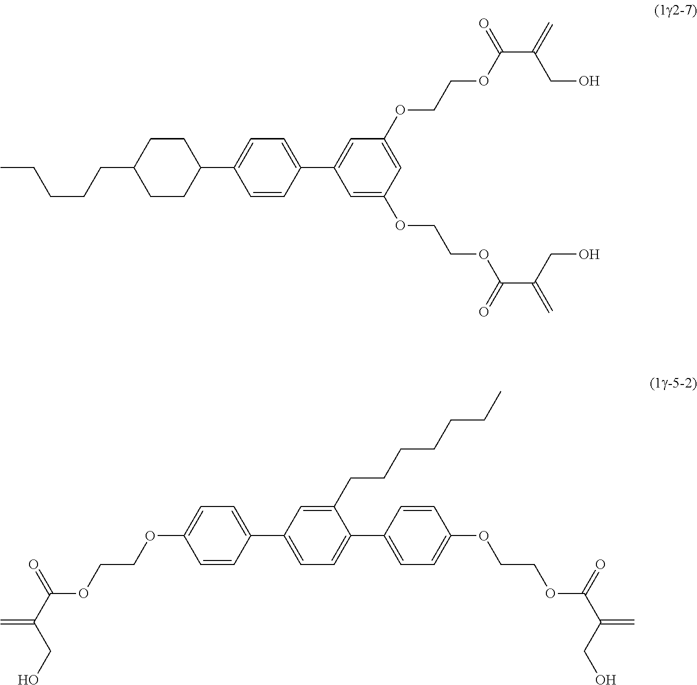 [SMILES: C=C(CO)C(=O)OCCOc1cc(OCCOC(=O)C(=C)CO)cc(-c2ccc(C3CCC(CCCCC)CC3)cc2)c1 ; C=C(CO)C(=O)OCCOc1ccc(-c2ccc(-c3ccc(OCCOC(=O)C(=C)CO)cc3)c(CCCCCCC)c2)cc1]

The polymerizable compound is polymerizable compound (M-1-1).

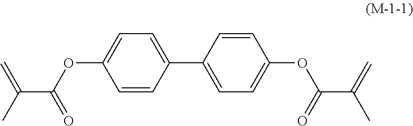 [SMILES: C=C(C)C(=O)Oc1ccc(-c2ccc(OC(=O)C(=C)C)cc2)cc1]

### Vertical Alignment of Liquid Crystal Molecules

### Example 22

Polar compound (1γ-2-7) was added to composition (iii) in a proportion of 5% by weight. The resulting mixture was injected, on a hot stage at 100° C., into a device having no alignment film in which a distance (cell gap) between two glass substrates was 4.0 micrometers. Polar compound (1γ-2-7) was polymerized by irradiating the device with ultraviolet light (28J) using an ultra-high pressure mercury lamp USH-250-BY (made by Ushio, Inc.). The device was set to a polarizing microscope in which a polarizer and an analyzer were arranged to directly go, and irradiated with light from below, and presence or absence of light leakage was observed. When no light passed through the device, the vertical alignment was judged to be “Good.” The reason is that liquid crystal molecules were presumed to be sufficiently aligned. When light passing through the device was observed, the vertical alignment was represented as “Poor.”

### Example 23, Comparative Example 22

A device having no alignment film was prepared by using a mixture prepared by adding a polar compound having a polymerizable group to a composition. Presence or absence of light leakage was observed in a manner similar to Example 22. The results are summarized in Table 8. In Example 23, polymerizable compound (M-1-1) was also added in a proportion of 0.5% by weight. In Comparative Example 22, polar compound (S-2) was selected for comparison. The reason is that the compound has no polymerizable group, and therefore is different from compound (1γ).

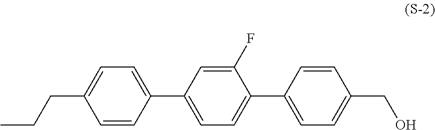 [SMILES: CCCc1ccc(-c2ccc(-c3ccc(CO)cc3)c(F)c2)cc1]

TABLE 8
Table 8: Vertical alignability of molecules

| | | Polar | Polymerizable | |
|---|---|---|---|---|
| | | compound | compound | |
| | Liquid crystal | (5% by | (0.5% by | Vertical |
| | composition | weight) | weight) | alignment |
| Example 22 | Composition | 1γ-2-7 | — | Good |
| | (iii) | | | |
| Example 23 | Composition | 1γ-5-2 | M-1-1 | Good |
| | (iv) | | | |
| Comparative | Composition | S-2 | — | Poor |
| Example 22 | (iii) | | | |

### 11. Synthesis Example of Compound (1δ)

### Synthesis Example 1δ: Synthesis of Compound (1δ-1-1)

In addition, compound (1δ-1-1) is identical to compound (1ε-6-1).

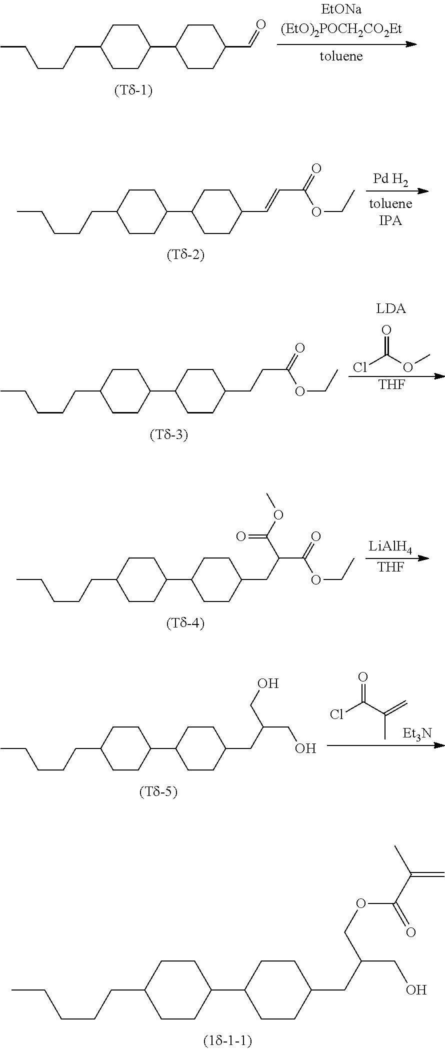

### First Step

Compound (Tδ-1) (40.0 g), triethyl phosphonoacetate (40.7 g) and toluene (800 mL) were put in a reaction vessel, and the resulting mixture was cooled down to 0° C. Sodium ethoxide (20% ethanol solution) (61.8 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tδ-2) (42.0 g; 83%).

### Second Step

Compound (Tδ-2) (42.0 g), toluene (400 mL) and isopropyl alcohol (400 mL) were put in a reaction vessel, Pd/C (0.7 g) was added thereto, and the resulting mixture was stirred at room temperature for 24 hours under a hydrogen atmosphere. The resulting reaction mixture was poured into water, and an aqueous layer was subjected to extraction with toluene. A combined organic layer was washed with brine and dried over anhydrous magnesium sulfate. The solution was concentrated under reduced pressure, and the residue was purified by silica gel chromatography (toluene:heptane=4:1 in a volume ratio) to obtain compound (Tδ-3) (40.1 g; 95%).

### Third Step

Compound (Tδ-3) (40.1 g) and THF (400 mL) were put in a reaction vessel, and the resulting mixture was cooled down to −60° C. Lithium diisopropylamide (LDA) (1.13 M; THF solution; 142 mL) was slowly added dropwise thereto, and the resulting mixture was stirred for 1 hour. Methyl chloroformate (11.0 mL) was slowly added dropwise thereto, and the resulting mixture was stirred for 5 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tδ-4) (30.5 g; 65%).

### Fourth Step

Lithium aluminum hydride (1.7 g) and THF (300 mL) were put in a reaction vessel, and the resulting mixture was cooled with ice. A THF (600 mL) solution of compound (Tδ-4) (30.5 g) was slowly added thereto, and the resulting mixture was stirred for 3 hours while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=1:1 in a volume ratio). The residue was further purified by recrystallization from heptane to obtain compound (Tδ-5) (20.1 g; 80%).

### Fifth Step

Compound (Tδ-5) (20.1 g), triethylamine (10.3 mL) and THF (200 mL) were put in a reaction vessel, and the resulting mixture was cooled down to 0° C. Methacryloyl chloride (6.0 mL) was slowly added dropwise thereto, and the resulting mixture was stirred for 4 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (1δ-1-1) (7.7 g; 32%).

An NMR analysis value of the resulting compound (1δ-1-1) was as described below.

¹H-NMR: chemical shift δ (ppm; CDCl₃): 6.11 (s, 1H), 5.58 (s, 1H), 4.29-4.26 (m, 1H), 4.14-4.11 (m, 1H), 3.60-3.57 (m, 1H), 3.50-3.47 (m, 1H), 1.98-1.95 (m, 5H), 1.78-1.67 (m, 8H), 1.32-1.11 (m, 12H), 0.99-0.81 (m, 13H)

Physical properties of compound (1δ-1-1) were as described below.

Transition temperature: C 65.0 I.

### Synthesis Example 25: Synthesis of Compound (1δ-1-2)

In addition, compound (1δ-1-2) is identical to compound (1ε-2-1).

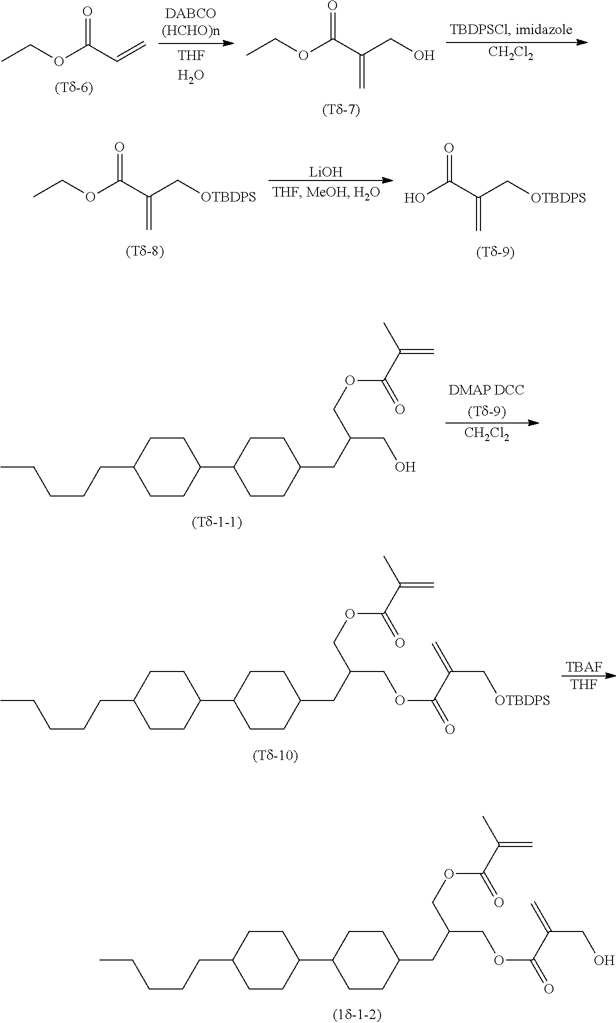

### First Step

Paraformaldehyde (30.0 g), 1,4-diazabicyclo[2.2.2]octane (DABCO) (56.0 g) and water (600 mL) were put in a reaction vessel, and the resulting mixture was stirred at room temperature for 15 minutes. A THF (1200 mL) solution of compound (Tδ-6) (50.0 g) was added dropwise thereto, and the resulting mixture was stirred at room temperature for 72 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=4:1 in a volume ratio) to obtain compound (Tδ-7) (43.2 g; 65%).

### Second Step

Compound (Tδ-7) (42.2 g) was used as a raw material, imidazole (26.3 g) and dichloromethane (800 mL) were put in a reaction vessel, and the resulting mixture was cooled down to 0° C. A dichloromethane (100 mL) solution of t-butyldiphenylchlorosilane (TBDPSCl) (106.4 g) was slowly added dropwise thereto, and the resulting mixture was stirred for 12 hours while returning to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=10:1 in a volume ratio) to obtain compound (Tδ-8) (107.0 g; 90%).

### Third Step

Compound (Tδ-8) (107.0 g), THF (800 mL), methanol (200 mL) and water (100 mL) were put in a reaction vessel, and the resulting mixture was cooled down to 0° C. Lithium hydroxide monohydrate (24.3 g) was added thereto, and the resulting mixture was stirred for 12 hours while returning to room temperature. The resulting reaction mixture was poured into water, and 6 N hydrochloric acid (100 mL) was slowly added thereto to acidify the resulting mixture, and then an aqueous layer was subjected to extraction with ethyl acetate. A combined organic layer was washed with water and dried over anhydrous magnesium sulfate. The solution was concentrated under reduced pressure, and the residue was purified by recrystallization from heptane to obtain compound (Tδ-9) (47.4 g; 48%).

### Fourth Step

Compound (1δ-1-1) (7.7 g), compound (Tδ-9) (8.0 g), DMAP (1.0 g) and dichloromethane (200 mL) were put in a reaction vessel, and the resulting mixture was cooled down to 0° C. A dichloromethane (60 mL) solution of N,N′-dicyclohexylcarbodiimide (DCC) (4.8 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=19:1 in a volume ratio) to obtain compound (Tδ-10) (9.8 g; 70%).

### Fifth Step

Compound (Tδ-10) (9.8 g) and THF (100 mL) were put in a reaction vessel, and the resulting mixture was cooled down to 0° C. Tetra-n-butylammonium fluoride (TBAF) (1.00 M; THF solution; 16.5 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (1δ-1-2) (3.1 g; 47%).

An NMR analysis value of the resulting compound (1δ-1-2) was as described below.

¹H-NMR: chemical shift δ (ppm; CDCl₃): 6.25 (s, 1H), 6.10 (s, 1H), 5.85 (s, 1H), 5.57 (s, 1H), 4.33 (d, J=4.5 Hz, 2H), 4.27-4.16 (m, 2H), 4.13-4.08 (m, 2H), 2.31 (s, 1H), 2.26-2.22 (m, 1H), 1.94 (s, 3H), 1, 81-1.61 (m, 8H), 1.32-1.08 (m, 12H), 1.00-0.79 (m, 13H).

Physical properties of compound (1δ-1-2) were as described below.

Transition temperature: C 49.6 I.

### Synthesis Example 35: Synthesis of Compound (1δ-1-3)

In addition, compound (1δ-1-3) is identical to compound (1ε-2-2).

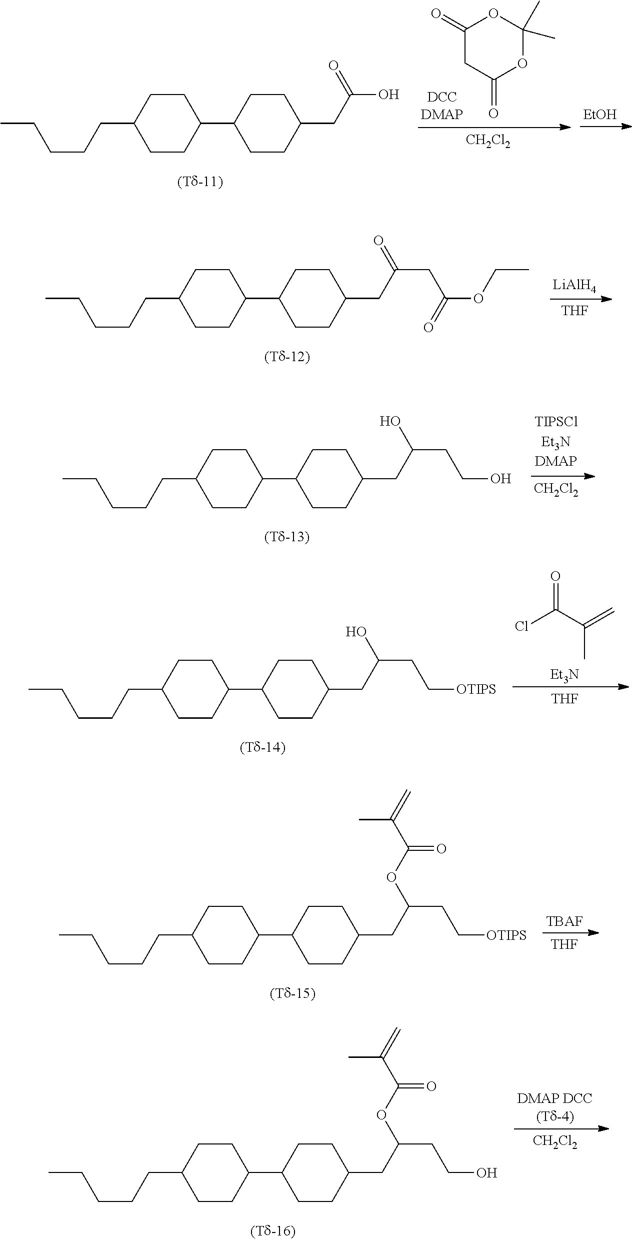

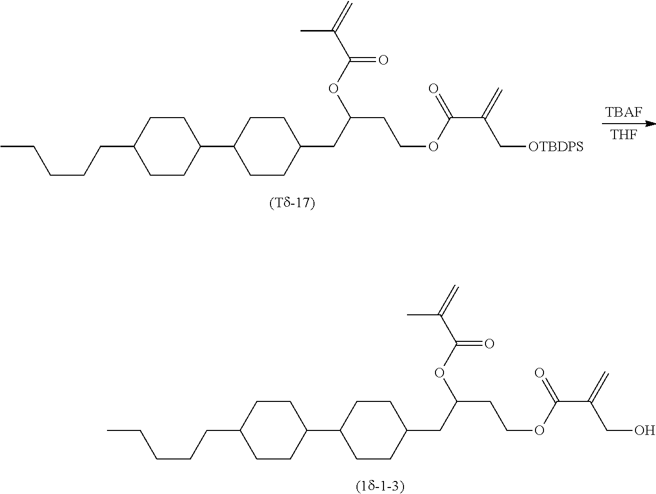

### First Step

Compound (Tδ-11) (15.0 g), N, N-dimethyl-4-aminopyridine (DMAP) (9.33 g), Meldrum's acid (9.54 g) and dichloromethane (250 mL) were put in a reaction vessel, and the resulting mixture was cooled down to 0° C. N,N′-dicyclohexylcarbodiimide (DCC) (15.7 g) was slowly added thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure. The residue and ethanol (250 mL) were put in a reaction vessel, and the resulting mixture was stirred at 70° C. An insoluble matter was filtered off, and then the resulting reaction mixture was poured into brine, and an aqueous layer was subjected to extraction with ethyl acetate. A combined organic layer was dried over anhydrous magnesium sulfate. The solution was concentrated under reduced pressure, and the residue was purified by silica gel chromatography (heptane:toluene=1:1 in a volume ratio) to obtain compound (Tδ-12) (10.2 g; 55%).

### Second Step

Lithium aluminum hydride (0.6 g) and THF (100 mL) were put in a reaction vessel, and the resulting mixture was cooled with ice. A THF (100 mL) solution of compound (Tδ-12) (10.2 g) was slowly added thereto, and the resulting mixture was stirred for 3 hours while returning to room temperature. An insoluble matter was filtered off, and then the resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=1:1 in a volume ratio) to obtain compound (Tδ-13) (7.35 g; 81%).

### Third Step

Compound (Tδ-13) (7.35 g), triethylamine (3.75 mL), N,N-dimethyl-4-aminopyridine (DMAP) (0.27 g) and dichloromethane (200 mL) were put in a reaction vessel, and the resulting mixture was cooled down to 0° C. TIPSCl (triisopropylsilyl chloride) (5.05 mL) was slowly added dropwise thereto, and the resulting mixture was stirred for 24 hours while returning to room temperature. An insoluble matter was filtered off, and then the resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=19:1 in a volume ratio) to obtain compound (Tδ-14) (6.50 g; 60%).

### Fourth Step

Compound (Tδ-14) (6.50 g), triethylamine (3.77 mL) and THF (200 mL) were put in a reaction vessel, and the resulting mixture was cooled down to 0° C. Methacryloyl chloride (2.00 mL) was slowly added dropwise thereto, and the resulting mixture was stirred for 4 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=1:1 in a volume ratio) to obtain compound (Tδ-15) (4.70 g; 63%).

### Fifth Step

Compound (Tδ-15) (4.70 g) and THF (100 mL) were put in a reaction vessel, and the resulting mixture was cooled down to 0° C. TBAF (1.00 M; THF solution; 10.3 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio) to obtain compound (Tδ-16) (1.50 g; 45%).

### Sixth Step

Compound (Tδ-17) (1.51 g; 55%) was obtained by using compound (Tδ-16) (1.50 g) as a raw material in a manner similar to the technique in the fourth step in Synthesis Example 25.

### Seventh Step

Compound (1δ-1-3) (0.45 g; 45%) was obtained by using compound (Tδ-17) (1.51 g) as a raw material in a manner similar to the technique in the fifth step in Synthesis Example 25.

An NMR analysis value of the resulting compound (1δ-1-3) was as described below.

¹H-NMR: chemical shift δ (ppm; CDCl₃): 6.25 (s, 1H), 6.09 (s, 1H), 5.82 (d, J=1.1 Hz, 1H), 5.55 (s, 1H), 5.22-5.17 (m, 1H), 4.32-4.26 (m, 3H), 4.17-4, 12 (m, 3H), 2.50 (s, 1H), 2.03-1.89 (m, 5H), 1.83-1.58 (m, 9H), 1.41-1.08 (m, 11H), 0.96-0.78 (m, 13H).

Physical properties of compound (1δ-1-3) were as described below.

Transition temperature: C 61.2 I.

### 12. Examples 31 to 33, Comparative Example 31

Examples as the device will be described below.

### Raw Material

A composition to which a polar compound was added was injected into a device having no alignment film. After the device was irradiated with ultraviolet light, vertical alignment of liquid crystal molecules in the device was examined. A raw material will be described first. As the raw material, compositions (iii) to (v), polar compounds (1δ-1-1) and (1δ-1-5) and polymerizable compound (M-1-1) were used. In addition, compositions (iii) and (iv) and polymerizable compound (M-1-1) are identical thereto used in Example 12.

A proportion of a component of composition (v) was expressed in terms of % by weight.

| | | |
|---|---|---|
| 3-HB(2F,3F)-O2 | (2-1) | 7% |
| 3-HB(2F,3F)-O4 | (2-1) | 8% |
| 3-H2B(2F,3F)-O2 | (2-2) | 8% |
| 3-BB(2F,3F)-O2 | (2-4) | 10% |
| 2-HHB(2F,3F)-O2 | (2-6) | 4% |
| 3-HHB(2F,3F)-O2 | (2-6) | 7% |
| 3-HHB(2F,3F)-1 | (2-6) | 6% |
| 2-HBB(2F,3F)-O2 | (2-10) | 6% |
| 3-HBB(2F,3F)-O2 | (2-10) | 6% |
| 4-HBB(2F,3F)-O2 | (2-10) | 5% |
| 5-HBB(2F,3F)-O2 | (2-10) | 4% |
| 3-HEB(2F,3F)B(2F,3F)-O2 | (2-11) | 3% |
| 3-H1OCro(7F,8F)-5 | (2-14) | 3% |
| 3-HDhB(2F,3F)-O2 | (2-16) | 5% |
| 3-HH-O1 | (3-1) | 5% |
| 1-BB-5 | (3-3) | 4% |
| V-HHB-1 | (3-5) | 4% |
| 5-HB(F)BH-3 | (3-12) | 5% |

NI=81.1° C.; Tc<−30° C.; Δn=0.119; Δε=−4.5; Vth=1.69 V; g=31.4 mPa·s.

The alignable monomer is polar compounds (1δ-1-1) and (1δ-1-5).

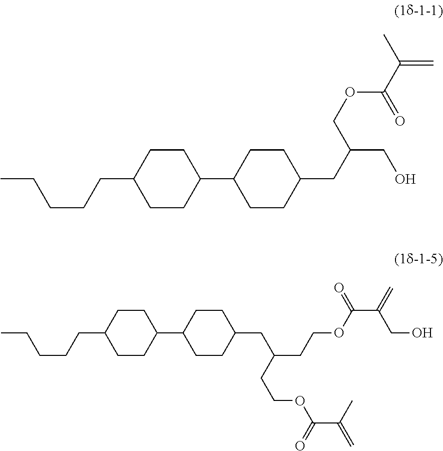

The polymerizable compound is polymerizable compound (M-1-1).

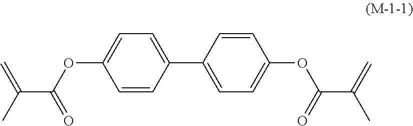 [SMILES: C=C(C)C(=O)Oc1ccc(-c2ccc(OC(=O)C(=C)C)cc2)cc1]

### Vertical Alignment of Liquid Crystal Molecules

### Example 31

Polar compound (1δ-1-1) was added to composition (iii) in a proportion of 5 parts by weight. The resulting mixture was injected, on a hot stage at 100° C., into a device having no alignment film in which a distance (cell gap) between two glass substrates was 4.0 micrometers. Polar compound (1δ-1-1) was polymerized by irradiating the device with ultraviolet light (28J) using an ultra-high pressure mercury lamp USH-250-BY (made by Ushio, Inc.). The device was set to a polarizing microscope in which a polarizer and an analyzer were arranged to directly go, and irradiated with light from below, and presence or absence of light leakage was observed. When liquid crystal molecules were sufficiently aligned and no light passed through the device, the vertical alignment was judged to be “Good.” When light passing through the device was observed, the vertical alignment was represented as “Poor.”

### Examples 32 to 33, Comparative Example 31

A device having no alignment film was prepared by using a mixture in which the composition and the polar compound were combined. Presence or absence of light leakage was observed in a manner similar to Example 31. The results are summarized in Table 9. In Example 33, polymerizable compound (M-1-1) was also added in a proportion of 0.5 part by weight. In Comparative Example 31, polar compound (S-3) described in Patent literature No. 5 was selected for comparison. The compound has no branching structure from a molecular terminal, and therefore is different from compound (1δ-1).

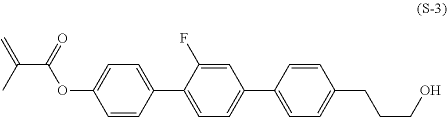 [SMILES: C=C(C)C(=O)Oc1ccc(-c2ccc(-c3ccc(CCCO)cc3)cc2F)cc1]

TABLE 9
Table 9: Vertical alignability of molecules

| | | Polar | Polymerizable | |
|---|---|---|---|---|
| | | compound | compound | |
| | Liquid crystal | (5 parts by | (0.5 part by | Vertical |
| | composition | weight) | weight) | alignment |
| Example 31 | Composition | 1δ-1-1 | — | Good |
| | (iii) | | | |
| Example 32 | Composition | 1δ-1-5 | — | Good |
| | (v) | | | |
| Example 33 | Composition | 1δ-1-5 | M-1-1 | Good |
| | (iv) | | | |
| Comparative | Composition | S-3 | — | Poor |
| Example 31 | (iii) | | | |

As shown in Table 9, in Examples 31 to 33, a kind of the composition or the polar compound and a concentration of the polar compound were changed, but no light leakage was observed. The above results indicate that the vertical alignment was good even without the alignment film in the device, and the liquid crystal molecules were stably aligned. In Example 33, polymerizable compound (M-1-1) was further added thereto, and the same results were obtained.

On the other hand, in Comparative Example 31, light leakage was observed. The above results indicate that the vertical alignment was poor.

### Compatibility of Polar Compound

In a state at room temperature, stability of the mixture of the liquid crystal composition and the polar compound as obtained in Examples 31 to 33 was evaluated. After mixing thereof, the mixture was allowed to be isotropic at 100° C. and to be cooled down to 25° C. When presence or absence of precipitation was confirmed a half day later at room temperature, precipitation of the mixture in Examples 31 to 33 was not confirmed, and compatibility of the polar compound was good. On the other hand, precipitation of the mixture in Comparative Example 31 was confirmed, and compatibility of the polar compound was poor.

### 13. Synthesis Example of Compound (1ε)

### Synthesis Example 1ε: Synthesis of Compound (1ε-6-1)

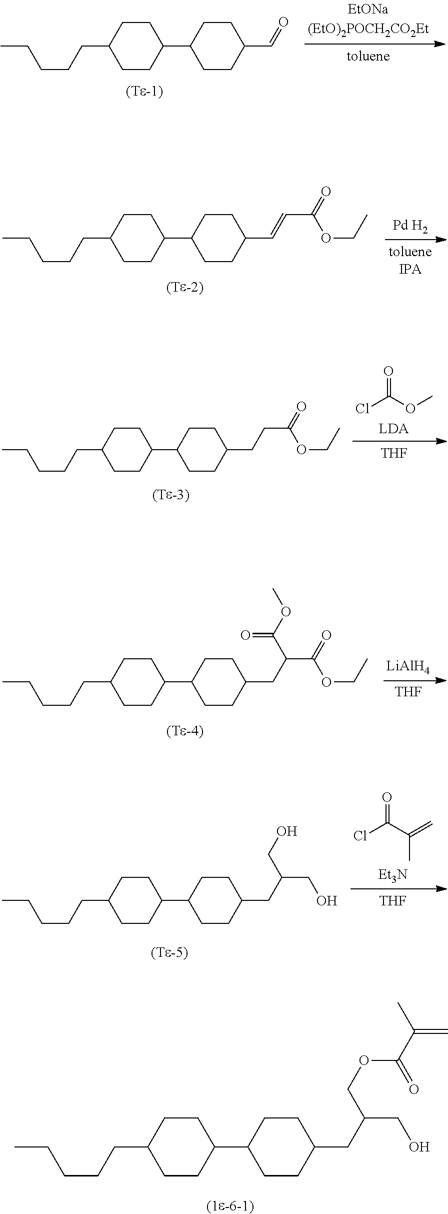

### First Step

Compound (Tε-1) (40.0 g), triethyl phosphonoacetate (40.7 g) and toluene (800 mL) were put in a reaction vessel, and the resulting mixture was cooled down to 0° C. Sodium ethoxide (20% ethanol solution) (61.8 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tε-2) (42.0 g; 83%).

### Second Step

Compound (Tε-2) (42.0 g), toluene (400 mL) and isopropanol (400 mL) were put in a reaction vessel, Pd/C (0.7 g) was added thereto, and the resulting mixture was stirred at room temperature for 24 hours under a hydrogen atmosphere. The resulting reaction mixture was poured into water, and an aqueous layer was subjected to extraction with toluene. A combined organic layer was washed with brine and dried over anhydrous magnesium sulfate. The solution was concentrated under reduced pressure, and the residue was purified by silica gel chromatography (toluene:heptane=4:1 in a volume ratio) to obtain compound (Tε-3) (40.1 g; 95%).

### Third Step

Compound (Tε-3) (40.1 g) and THF (400 mL) were put in a reaction vessel, and the resulting mixture was cooled down to −60° C. Lithium diisopropylamide (LDA) (1.13 M; THF solution; 142 mL) was slowly added dropwise thereto, and the resulting mixture was stirred for 1 hour. Methyl chloroformate (11.0 mL) was slowly added dropwise thereto, and the resulting mixture was stirred for 5 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tε-4) (30.5 g; 65%).

### Fourth Step

Lithium aluminum hydride (1.7 g) and THF (300 mL) were put in a reaction vessel, and the resulting mixture was cooled with ice. A THF (600 mL) solution of compound (Tε-4) (30.5 g) was slowly added thereto, and the resulting mixture was stirred for 3 hours while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=1:1 in a volume ratio). The residue was further purified by recrystallization from heptane to obtain compound (Tε-5) (20.1 g; 80%).

### Fifth Step

Compound (Tε-5) (20.1 g), triethylamine (10.3 mL) and THF (200 mL) were put in a reaction vessel, and the resulting mixture was cooled down to 0° C. Methacryloyl chloride (6.0 mL) was slowly added dropwise thereto, and the resulting mixture was stirred for 4 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (1ε-6-1) (7.7 g; 32%).

An NMR analysis value of the resulting compound (1ε-6-1) was as described below.

¹H-NMR: chemical shift δ (ppm; CDCl₃): 6.11 (s, 1H), 5.58 (s, 1H), 4.29-4.26 (m, 1H), 4.14-4.11 (m, 1H), 3.60-3.57 (m, 1H), 3.50-3.47 (m, 1H), 1.98-1.95 (m, 5H), 1.78-1.67 (m, 8H), 1.32-1.11 (m, 12H), 0.99-0.81 (m, 13H)

Physical properties of compound (1ε-6-1) were as described below.

Transition temperature: C 65.0 I.

### Synthesis Example 2ε: Synthesis of Compound (1ε-2-1)

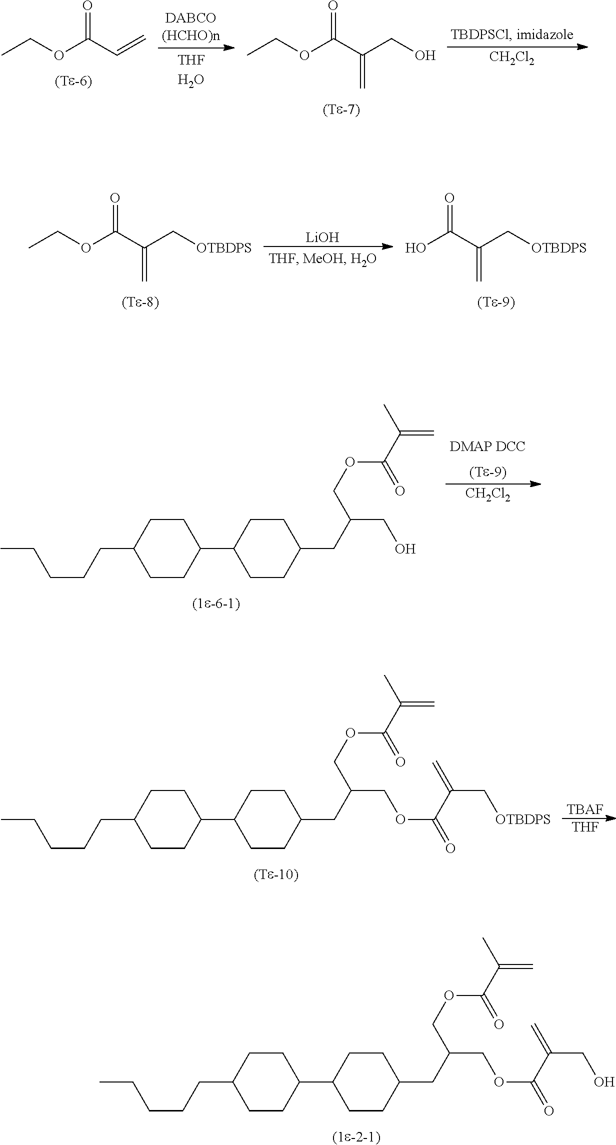

### First Step

Paraformaldehyde (30.0 g), DABCO (56.0 g) and water (600 mL) were put in a reaction vessel, and the resulting mixture was stirred at room temperature for 15 minutes. A THF (1200 mL) solution of compound (Tε-6) (50.0 g) was added dropwise thereto, and the resulting mixture was stirred at room temperature for 72 hours. The resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=4:1 in a volume ratio) to obtain compound (Tε-7) (43.2 g; 65%).

### Second Step

Compound (Tε-7) (42.2 g) was used as a raw material, imidazole (26.3 g) and dichloromethane (800 mL) were put in a reaction vessel, and the resulting mixture was cooled down to 0° C. A dichloromethane (100 mL) solution of t-butyldiphenylchlorosilane (106.4 g) was slowly added dropwise thereto, and the resulting mixture was stirred for 12 hours while returning to room temperature. The resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=10:1 in a volume ratio) to obtain compound (Tε-8) (107.0 g; 90%).

### Third Step

Compound (Tε-8) (107.0 g), THF (800 mL), methanol (200 mL) and water (100 mL) were put in a reaction vessel, and the resulting mixture was cooled down to 0° C. Lithium hydroxide monohydrate (24.3 g) was added thereto, and the resulting mixture was stirred for 12 hours while returning to room temperature. The resulting reaction mixture was poured into water, and 6 N hydrochloric acid (100 mL) was slowly added thereto to acidify the resulting mixture, and then an aqueous layer was subjected to extraction with ethyl acetate. A combined organic layer was washed with water and dried over anhydrous magnesium sulfate. The solution was concentrated under reduced pressure, and the residue was purified by recrystallization from heptane to obtain compound (Tε-9) (47.4 g; 48%).

### Fourth Step

Compound (1ε-6-1) (7.7 g), compound (Tε-9) (8.0 g), DMAP (1.0 g) and dichloromethane (200 mL) were put in a reaction vessel, and the resulting mixture was cooled down to 0° C. A dichloromethane (60 mL) solution of DCC (4.8 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=19:1 in a volume ratio) to obtain compound (Tε-10) (9.8 g; 70%).

### Fifth Step

Compound (Tε-10) (9.8 g) and THF (100 mL) were put in a reaction vessel, and the resulting mixture was cooled down to 0° C. TBAF (1.00 M; THF solution; 16.5 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio). The residue was further purified by recrystallization from heptane to obtain compound (1ε-2-1) (3.1 g; 47%).

An NMR analysis value of the resulting compound (1ε-2-1) was as described below.

¹H-NMR: chemical shift δ (ppm; CDCl₃): 6.25 (s, 1H), 6.10 (s, 1H), 5.85 (s, 1H), 5.57 (s, 1H), 4.33 (d, J=4.5 Hz, 2H), 4.27-4.16 (m, 2H), 4.13-4.08 (m, 2H), 2.31 (s, 1H), 2.26-2.22 (m, 1H), 1.94 (s, 3H), 1, 81-1.61 (m, 8H), 1.32-1.08 (m, 12H), 1.00-0.79 (m, 13H).

Physical properties of compound (1ε-2-1) were as described below.

Transition temperature: C 49.6 I.

### Synthesis Example 3ε: Synthesis of Compound (1ε-2-2)

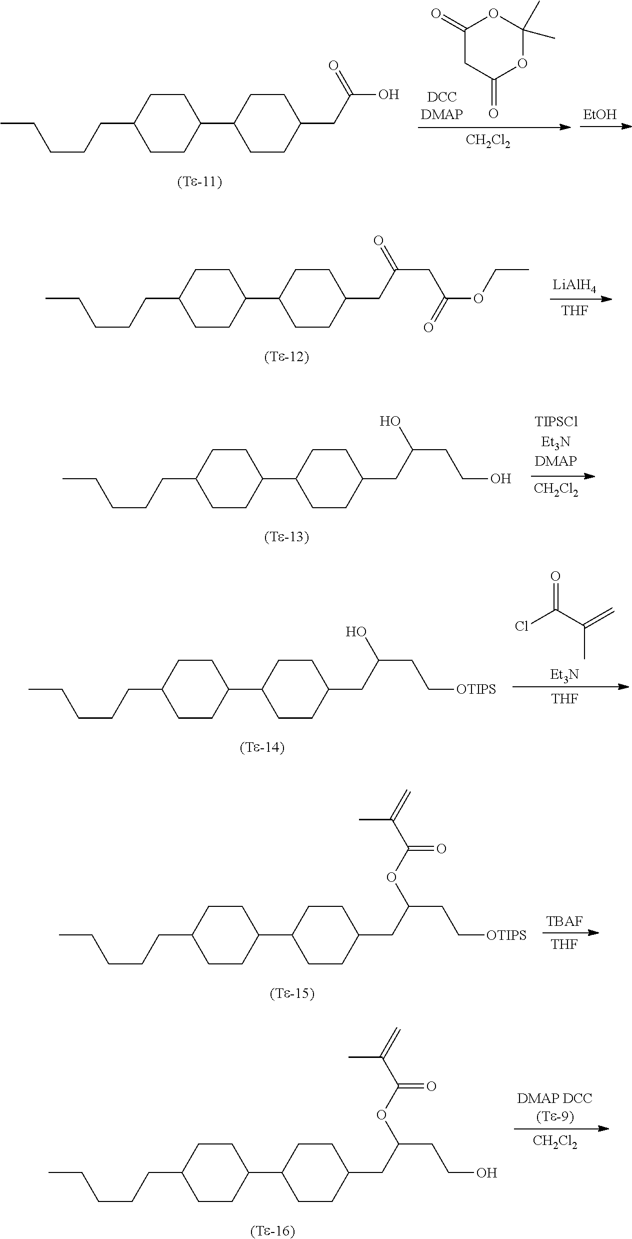

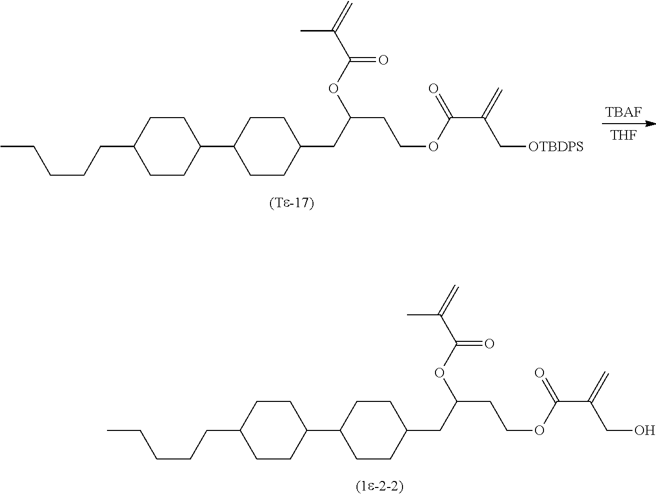

### First Step

Compound (Tε-11) (15.0 g), DMAP (9.33 g), Meldrum's acid (9.54 g) and dichloromethane (250 mL) were put in a reaction vessel, and the resulting mixture was cooled down to 0° C. DCC (15.7 g) was slowly added thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure. The residue and ethanol (250 mL) were put in a reaction vessel, and the resulting mixture was stirred at 70° C. An insoluble matter was filtered off, and then the resulting reaction mixture was poured into brine, and an aqueous layer was subjected to extraction with ethyl acetate. A combined organic layer was dried over anhydrous magnesium sulfate. The solution was concentrated under reduced pressure, and the residue was purified by silica gel chromatography (heptane:toluene=1:1 in a volume ratio) to obtain compound (Tε-12) (10.2 g; 55%).

### Second Step

Lithium aluminum hydride (0.6 g) and THF (100 mL) were put in a reaction vessel, and the resulting mixture was cooled with ice. A THF (100 mL) solution of compound (Tε-12) (10.2 g) was slowly added thereto, and the resulting mixture was stirred for 3 hours while returning to room temperature. An insoluble matter was filtered off, and then the resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=1:1 in a volume ratio) to obtain compound (Tε-13) (7.35 g; 81%).

### Third Step

Compound (Tε-13) (7.35 g), triethylamine (3.75 mL), N,N-dimethyl-4-aminopyridine (DMAP) (0.27 g) and dichloromethane (200 mL) were put in a reaction vessel, and the resulting mixture was cooled down to 0° C. TIPSCl (triisopropylsilyl chloride) (5.05 mL) was slowly added dropwise thereto, and the resulting mixture was stirred for 24 hours while returning to room temperature. An insoluble matter was filtered off, and then the resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=19:1 in a volume ratio) to obtain compound (Tε-14) (6.50 g; 60%).

### Fourth Step

Compound (Tε-14) (6.50 g), triethylamine (3.77 mL) and THF (200 mL) were put in a reaction vessel, and the resulting mixture was cooled down to 0° C. Methacryloyl chloride (2.00 mL) was slowly added dropwise thereto, and the resulting mixture was stirred for 4 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=1:1 in a volume ratio) to obtain compound (Tε-15) (4.70 g; 63%).

### Fifth Step

Compound (Tε-15) (4.70 g) and THF (100 mL) were put in a reaction vessel, and the resulting mixture was cooled down to 0° C. TBAF (1.00 M; THF solution; 10.3 mL) was slowly added thereto, and the resulting mixture was stirred for 1 hour while returning to room temperature. The resulting reaction mixture was poured into water, and an aqueous layer was subjected to extraction with ethyl acetate. A combined organic layer was washed with brine and dried over anhydrous magnesium sulfate. The solution was concentrated under reduced pressure, and the residue was purified by silica gel chromatography (toluene:ethyl acetate=9:1 in a volume ratio) to obtain compound (Tε-16) (1.50 g; 45%).

### Sixth Step

Compound (Tε-17) (1.51 g; 55%) was obtained by using compound (Tε-16) (1.50 g) as a raw material in a manner similar to the technique in the fourth step in Synthesis Example 2ε.

### Seventh Step

Compound (1ε-2-2) (0.45 g; 45%) was obtained by using compound (Tε-17) (1.51 g) as a raw material in a manner similar to the technique in the fifth step in Synthesis Example 2ε.

An NMR analysis value of the resulting compound (1ε-2-2) was as described below.

¹H-NMR: chemical shift δ (ppm; CDCl₃): 6.25 (s, 1H), 6.09 (s, 1H), 5.82 (d, J=1.1 Hz, 1H), 5.55 (s, 1H), 5.22-5.17 (m, 1H), 4.32-4.26 (m, 3H), 4.17-4, 12 (m, 3H), 2.50 (s, 1H), 2.03-1.89 (m, 5H), 1.83-1.58 (m, 9H), 1.41-1.08 (m, 11H), 0.96-0.78 (m, 13H).

Physical properties of compound (1ε-2-2) were as described below.

Transition temperature: C 61.2 I.

### Synthesis Example 4ε: Synthesis of Compound (1ε-9-1)

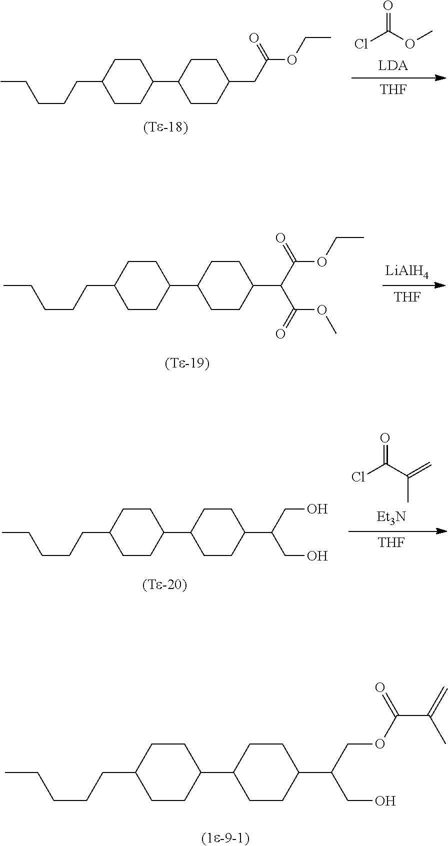

### First Step

Compound (Tε-18) (20.0 g) and THF (200 mL) were put in a reaction vessel, the resulting mixture was cooled down to −70° C., and Lithium diisopropylamide (LDA) (1.10M; THF solution; 68.0 mL) was slowly added dropwise thereto, and the resulting mixture was stirred for 1 hour. Methyl chloroformate (7.00 g) was slowly added thereto, and the resulting mixture was stirred for 4 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=9:1 in a volume ratio) to obtain compound (Tε-19) (19.4 g; 82%).

### Second Step

Lithium aluminium hydride (1.93 g) and THF (200 mL) were put in a reaction vessel, and the resulting mixture was cooled down to 0° C. A THF (100 mL) solution of compound (Tε-19) (19.4 g) was slowly added thereto, and the resulting mixture was stirred for 3 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio) to obtain compound (Tε-20) (6.0 g; 38%).

### Third Step

Compound (Tε-20) (6.0 g), triethylamine (3.2 mL) and THF (100 mL) were put in a reaction vessel, and the resulting mixture was cooled down to 0° C. Methacryloyl chloride (1.8 mL) was slowly added thereto, and the resulting mixture was stirred for 5 hours while returning to room temperature. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (1ε-9-1) (2.5 g; 34%).

An NMR analysis value of the resulting compound (1ε-9-1) was as described below.

¹H-NMR: chemical shift δ (ppm; CDCl₃): 6.10 (s, 1H), 5.57 (d, J=1.1 Hz, 1H), 4.38 (dd, J=11.4 Hz, J=4.3 Hz, 1H), 4.23 (dd, J=11.3 Hz, J=6.7 Hz, 1H), 3.71-3.68 (m, 1H), 3.63-3.60 (m, 1H), 1.97 (s, 1H), 1.94 (s, 3H), 1.82-1.62 (m, 9H), 1.41-1.18 (m, 7H), 1.14-0.79 (m, 16H).

Physical properties of compound (1ε-9-1) were as described below.

Transition temperature: C 68.4 S_{A} 89.3 I.

### Synthesis Example 5ε: Synthesis of Compound (1ε-9-2)

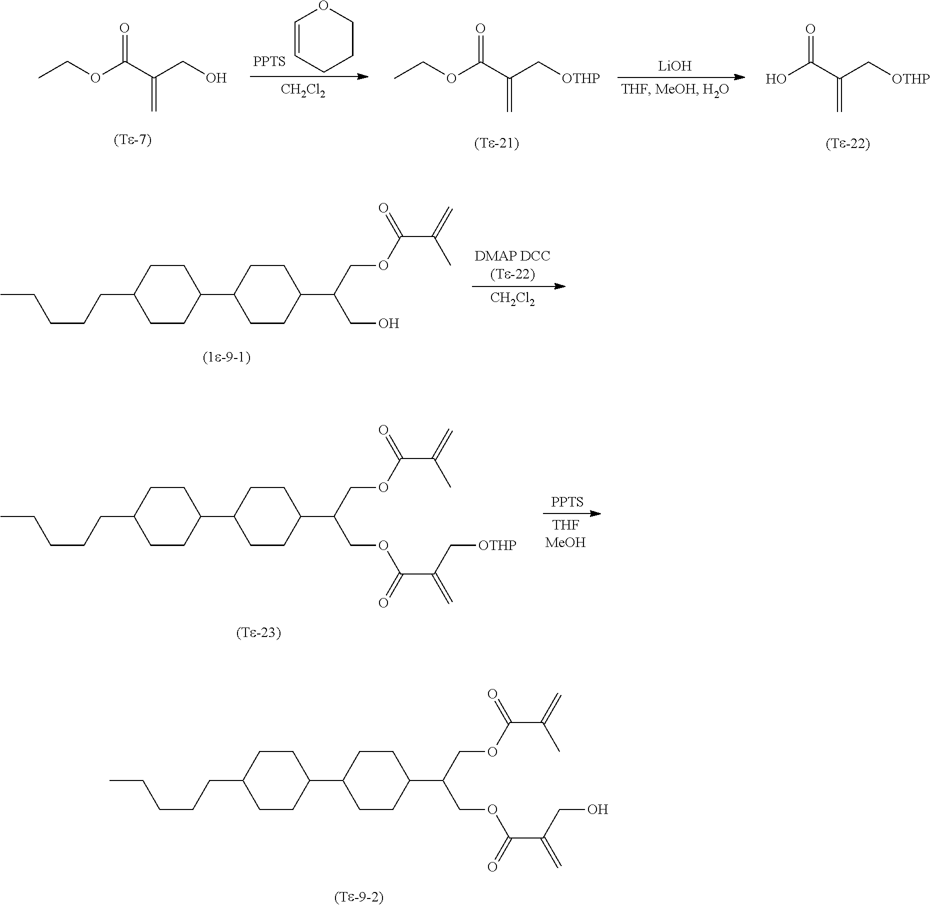

### First Step

Compound (Tε-7), 3,4-dihydro-2H-pyran (23.3 g) and pyridinium p-toluenesulfonate (PPTS) (5.80 g) were put in a reaction vessel, and the resulting mixture was stirred at 50° C. for 10 hours. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (heptane:ethyl acetate=2:1 in a volume ratio) to obtain compound (Tε-21) (39.5 g; 80%).

### Second Step

Compound (Tε-21) (39.5 g), THF (400 mL) and water (400 mL) were put in a reaction vessel, and the resulting mixture was cooled down to 0° C. Lithium hydroxide monohydrate (15.4 g) was added thereto, and the resulting mixture was stirred for 12 hours while returning to room temperature. The resulting reaction mixture was poured into water, and 6 N hydrochloric acid (60 mL) was slowly added thereto to acidify the resulting mixture, and then an aqueous layer was subjected to extraction with ethyl acetate. A combined organic layer was washed with water and dried over anhydrous magnesium sulfate. The solution was concentrated under reduced pressure to obtain compound (Tε-22) (32.6 g; 95%).

### Third Step

Compound (1ε-9-1) (2.0 g), compound (Tε-22) (1.18 g), DMAP (0.32 g) and dichloromethane (100 mL) were put in a reaction vessel, and the resulting mixture was cooled down to 0° C. A dichloromethane (60 mL) solution of DCC (1.30 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (toluene:ethyl acetate=19:1 in a volume ratio) to obtain compound (Tε-23) (2.37 g; 82%).

### Fourth Step

Compound (Tε-23) (2.37 g), pyridinium p-toluenesulfonate (PPTS) (0.54 g), THF (50 mL) and methanol (50 mL) were put in a reaction vessel, and the resulting mixture was stirred at 50° C. for 5 hours. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (1ε-9-2) (1.50 g; 75%).

An NMR analysis value of the resulting compound (1ε-9-2) was as described below.

¹H-NMR: chemical shift δ (ppm; CDCl₃): 6.24 (s, 1H), 6.09 (s, 1H), 5.84 (s, 1H), 5.57 (s, 1H), 4.33-4.27 (m, 4H), 4.20-4.16 (m, 2H), 2.34-2.31 (m, 1H), 1.97-1.90 (m, 4H), 1.82-1.67 (m, 8H), 1.43-1.39 (m, 1H), 1.31-1.18 (m, 6H), 1.15-0.75 (m, 16H).

Physical properties of compound (1ε-9-2) were as described below.

Transition temperature: C 66.5 I.

### Synthesis Example 6ε: Synthesis of Compound (1ε-9-3)

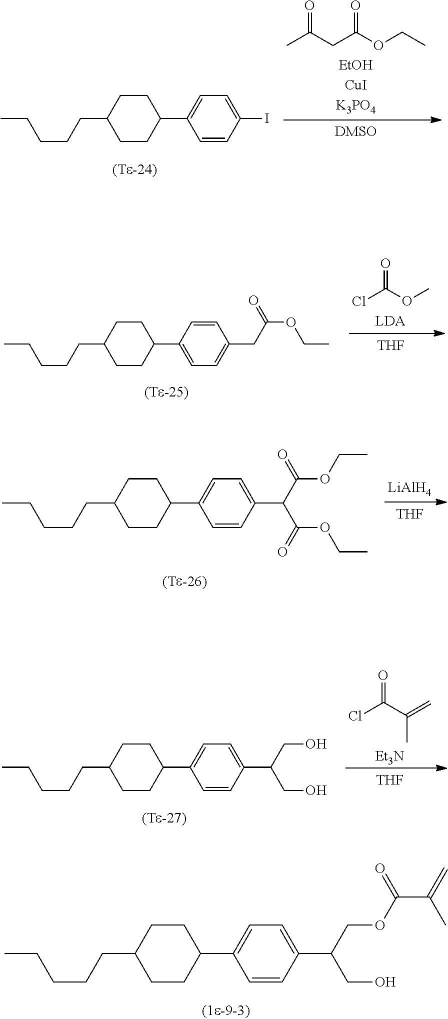

### First Step

Compound (Tε-24) (30.0 g), ethanol (14.4 mL), potassium phosphate (53.6 g), copper iodide (1.60 g), ethyl acetoacetate (32.8 g) and dimethyl sulfoxide (DMSO) (500 mL) were put in a reaction vessel, and the resulting mixture was stirred at 80° C. for 6 hours. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tε-25) (19.5 g; 73%).

### Second Step

Compound (Tε-26) (16.2 g; 70%) was obtained by using compound (Tε-25) (19.5 g) as a raw material in a manner similar to the technique in the first step in Synthesis Example 4E.

### Third Step

Compound (Tε-27) (6.0 g; 45%) was obtained by using compound (Tε-26) (16.2 g) as a raw material in a manner similar to the technique in the second step in Synthesis Example 4ε.

### Fourth Step

Compound (1ε-9-3) (2.3 g; 31%) was obtained by using compound (Tε-27) (6.0 g) as a raw material in a manner similar to the technique in the third step in Synthesis Example 4E.

An NMR analysis value of the resulting compound (1ε-9-3) was as described below.

¹H-NMR: chemical shift δ (ppm; CDCl₃): 7.18-7.17 (m, 4H), 6.09 (s, 1H), 5.57 (s, 1H), 4.47-4.38 (m, 2H), 3.91-3.85 (m, 2H), 3.19-3.14 (m, 1H), 2.44 (tt, J=12.2 Hz, J=3.0 Hz, 1H), 1.93-1.86 (m, 8H), 1.48-1.38 (m, 2H), 1.34-1.19 (m, 9H), 1.07-0.99 (m, 2H), 0.89 (t, J=6.8 Hz, 3H).

Physical properties of compound (1ε-9-3) were as described below.

Transition temperature: C 36.1 I.

### Synthesis Example 7ε: Synthesis of Compound (1ε-9-4)

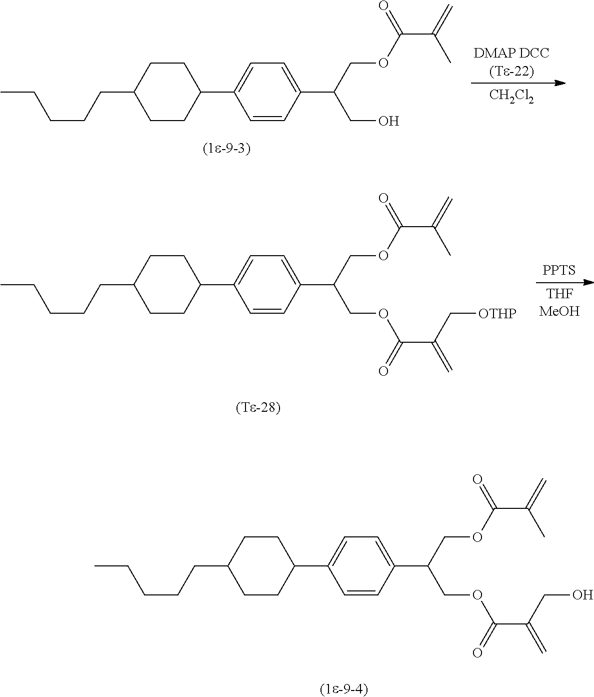

### First Step

Compound (Tε-28) (2.2 g; 76%) was obtained by using compound (1ε-9-3) (2.0 g) as a raw material in a manner similar to the technique in the third step in Synthesis Example 5ε.

### Second Step

Compound (1ε-9-4) (1.3 g; 70%) was obtained by using compound (Tε-28) (2.2 g) as a raw material in a manner similar to the technique in the fourth step in Synthesis Example 5ε.

An NMR analysis value of the resulting compound (1ε-9-4) was as described below.

¹H-NMR: chemical shift δ (ppm; CDCl₃): 7.17-7.16 (m, 4H), 6.21 (s, 1H), 6.07 (s, 1H), 5.81 (d, J=1.0 Hz, 1H), 5.55 (s, 1H), 4.46-4.39 (m, 4H), 4.27 (d, J=6.2 Hz, 2H), 3.42-3.37 (m, 1H), 2.44 (tt, J=12.2 Hz, J=3.1 Hz, 1H), 2.22-2.21 (m, 1H), 1.95 (s, 3H), 1.87-1.85 (m, 4H), 1.46-1.38 (m, 2H), 1.34-1.19 (m, 9H), 1.07-0.99 (m, 2H), 0.89 (t, J=7.0 Hz, 3H).

Physical properties of compound (1ε-9-4) were as described below.

Transition temperature: C 52.3 I.

### Synthesis Example 8ε: Synthesis of Compound (1ε-9-5)

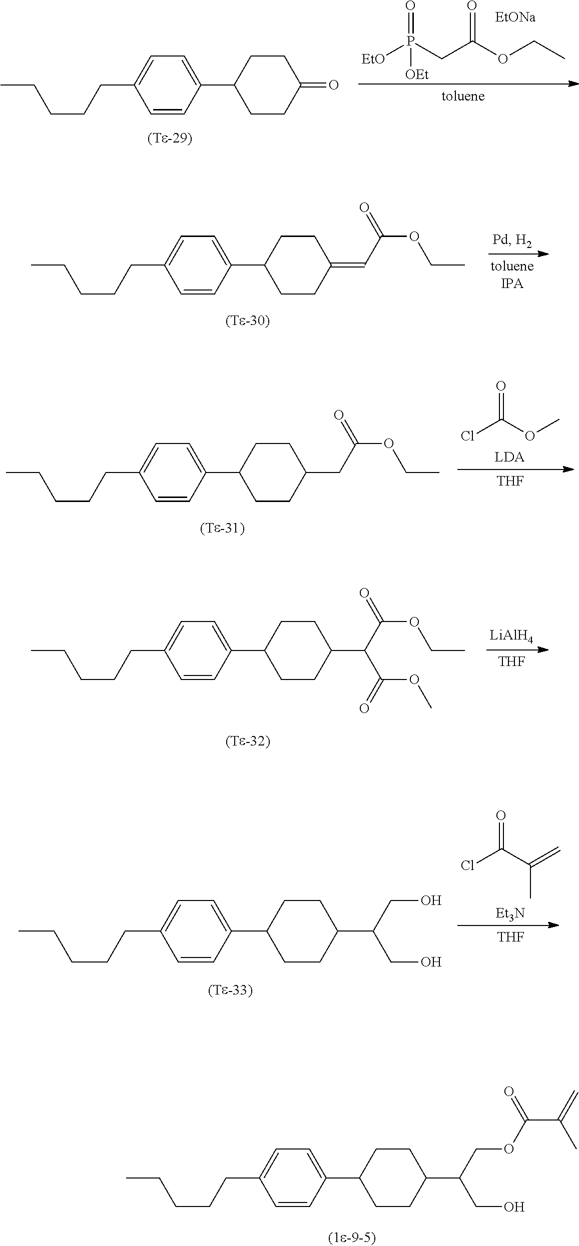

### First Step

Compound (Tε-29) (30.0 g), triethyl phosphonoacetate (33.0 g) and toluene (500 mL) were put in a reaction vessel, and the resulting mixture was cooled down to 0° C. Sodium ethoxide (20% ethanol solution) (50.1 g) was slowly added dropwise thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio) to obtain compound (Tε-30) (32.8 g; 85%).

### Second Step

Compound (Tε-30) (32.8 g), toluene (300 mL), IPA (300 mL) and Pd/C (0.55 g) were put in a reaction vessel, and the resulting mixture was stirred for 12 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=4:1 in a volume ratio). The residue was further purified by recrystallization from heptane to obtain compound (Tε-31) (16.8 g; 51%).

### Third Step

Compound (Tε-32) (14.1 g; 71%) was obtained by using compound (Tε-31) (16.8 g) as a raw material in a manner similar to the technique in the first step in Synthesis Example 4ε.

### Fourth Step

Compound (Tε-33) (6.0 g; 52%) was obtained by using compound (Tε-32) (14.1 g) as a raw material in a manner similar to the technique in the second step in Synthesis Example 4ε.

### Fifth Step

Compound (1ε-9-5) (2.3 g; 32%) was obtained by using compound (Tε-33) (6.0 g) as a raw material in a manner similar to the technique in the third step in Synthesis Example 4ε.

An NMR analysis value of the resulting compound (1ε-9-5) was as described below.

¹H-NMR: chemical shift δ (ppm; CDCl₃): 7.14-7.10 (m, 4H), 6.12 (s, 1H), 5.59 (s, 1H), 4.43-4.40 (m, 1H), 4.28-4.25 (m, 1H), 3.75-3.64 (m, 2H), 2.55 (t, J=7.6 Hz, 2H), 2.47-2.42 (m, 1H), 2.14 (s, 1H), 1.96-1.91 (m, 7H), 1.74-1.69 (m, 1H), 1.62-1.22 (m, 11H), 0.88 (t, J=6.8 Hz, 3H).

Physical properties of compound (1ε-9-5) were as described below.

Transition temperature: C<−50.0 I.

### Synthesis Example 9ε: Synthesis of Compound (1ε-9-6)

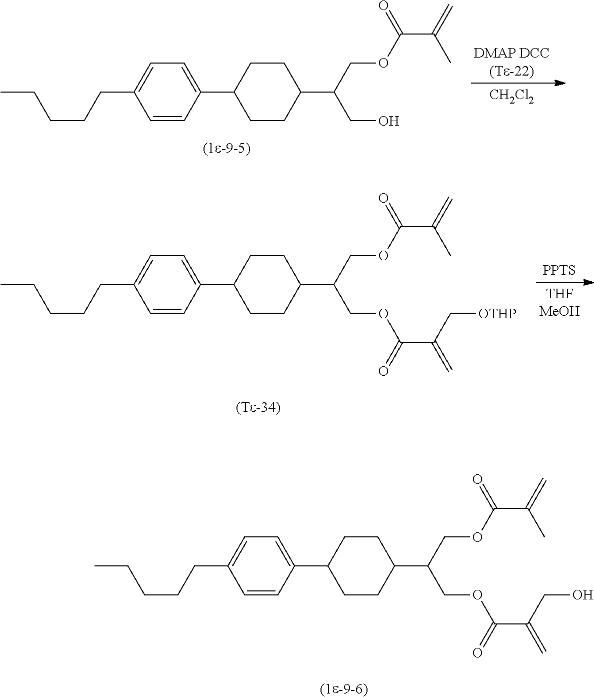

### First Step

Compound (Tε-34) (1.9 g; 68%) was obtained by using compound (1ε-9-5) (2.0 g) as a raw material in a manner similar to the technique in the third step in Synthesis Example 5ε.

### Second Step

Compound (1ε-9-6) (1.2 g; 75%) was obtained by using compound (Tε-34) (1.9 g) as a raw material in a manner similar to the technique in the fourth step in Synthesis Example 5ε.

An NMR analysis value of the resulting compound (1ε-9-6) was as described below.

¹H-NMR: chemical shift δ (ppm; CDCl₃): 7.13-7.10 (m, 4H), 6.27 (s, 1H), 6.11 (s, 1H), 5.86 (s, 1H), 5.58 (s, 1H), 4.40-4.32 (m, 4H), 4.25-4.20 (m, 2H), 2.56 (t, J=7.6 Hz, 2H), 2.45 (tt, J=12.1 Hz, J=2.9 Hz, 1H), 2.35-2.32 (m, 1H), 2.04-1.91 (m, 7H), 1.62-1.26 (m, 12H), 0.88 (t, J=6.8 Hz, 3H).

Physical properties of compound (1ε-9-6) were as described below.

Transition temperature: C 35.8 I.

### Synthesis Example 10ε: Synthesis of Compound (1ε-9-7)

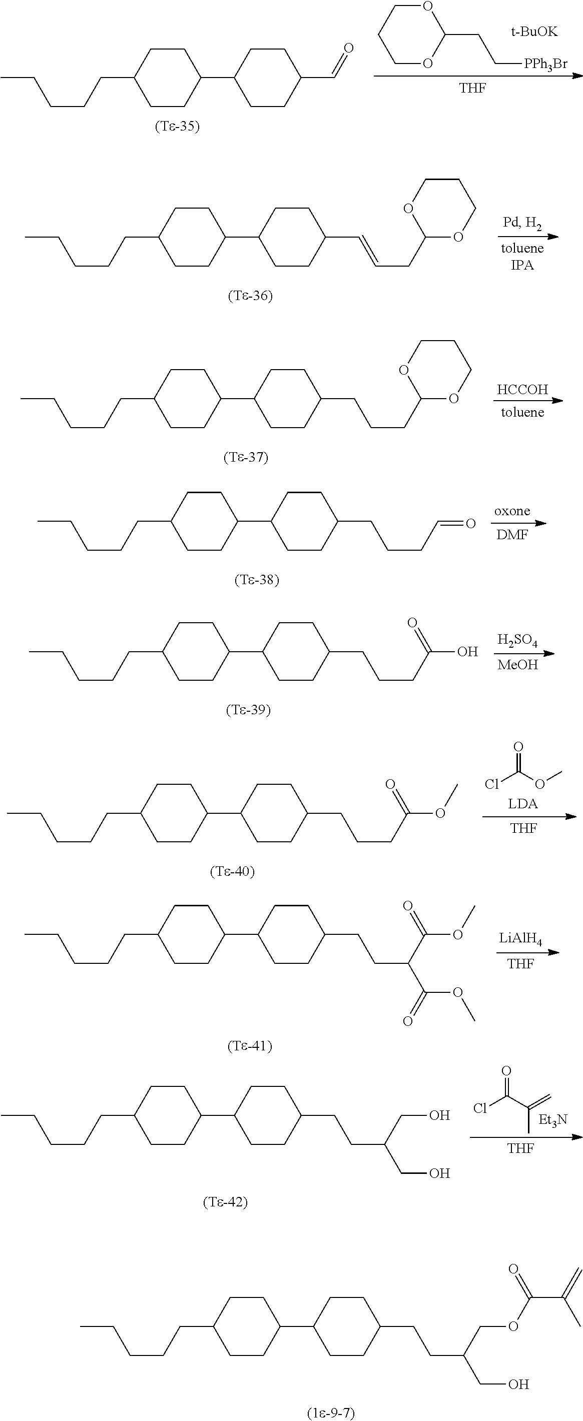

### First Step

Then, 2-(1,3-dioxan-2-yl)ethyltriphenylphosphonium bromide (103.7 g) and THF (500 mL) were put in a reaction vessel, the resulting mixture was cooled down to −30° C., and potassium t-butoxide (25.4 g) was added thereto, and the resulting mixture was stirred for 1 hour. A THF (300 mL) solution of compound (Tε-35) (50.0 g) was slowly added dropwise thereto, and the resulting mixture was stirred for 6 hours while returning to room temperature. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=1:1 in a volume ratio) to obtain compound (Tε-36) (63.0 g; 92%).

### Second Step

Compound (Tε-36) (63.0 g), toluene (500 mL), IPA (500 mL) and Pd/C (0.55 g) were put in a reaction vessel, and the resulting mixture was stirred for 16 hours under a hydrogen atmosphere. An insoluble matter was filtered off, and then the resulting reaction mixture was poured into water, and an aqueous layer was subjected to extraction with toluene. A combined organic layer was washed with water and dried over anhydrous magnesium sulfate. The solution was concentrated under reduced pressure, and the residue was purified by silica gel chromatography (toluene:heptane=1:1 in a volume ratio) to obtain compound (Tε-37) (60.1 g; 95%).

### Third Step

Compound (Tε-37) (60.1 g), formic acid (75.8 g) and toluene (1000 mL) were put in a reaction vessel, and the resulting mixture was stirred at 100° C. for 6 hours. An insoluble matter was filtered off, and then the resulting material was neutralized with a sodium hydrogencarbonate aqueous solution, and an aqueous layer was subjected to extraction with toluene. A combined organic layer was washed with water and dried over anhydrous magnesium sulfate. The solution was concentrated under reduced pressure, and the residue was purified by silica gel chromatography with toluene to obtain compound (Tε-38) (45.0 g; 89%).

### Fourth Step

Compound (Tε-38) (45.0 g), potassium peroxymonosulfate (OXONE) (108.3 g) and DMF (1000 mL) were put in a reaction vessel, and the resulting mixture was stirred at room temperature for 8 hours. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure to obtain compound (Tε-39) (28.5 g; 60%).

### Fifth Step

Compound (Tε-39) (28.5 g), sulfuric acid (0.5 mL) and methanol (500 mL) were put in a reaction vessel, and the resulting mixture was stirred at 60° C. for 5 hours. An insoluble matter was filtered off, and then the resulting material was concentrated, and the residue was purified by silica gel chromatography with toluene to obtain compound (Tε-40) (22.3 g; 75%).

### Sixth Step

Compound (Tε-41) (18.3 g; 70%) was obtained by using compound (Tε-40) (22.3 g) as a raw material in a manner similar to the technique in the first step in Synthesis Example 4E.

### Seventh Step

Compound (Tε-42) (5.9 g; 38%) was obtained by using compound (Tε-41) (18.3 g) as a raw material in a manner similar to the technique in the second step in Synthesis Example 4E.

### Eighth Step

Compound (1ε-9-7) (2.4 g; 34%) was obtained by using compound (Tε-42) (5.9 g) as a raw material in a manner similar to the technique in the third step in Synthesis Example 4E.

An NMR analysis value of the resulting compound (1ε-9-7) was as described below.

¹H-NMR: chemical shift δ (ppm; CDCl₃): 6.11 (s, 1H), 5.81 (s, 1H), 4.31-4.28 (m, 1H), 4.17-4.14 (m, 1H), 3.63-3.58 (m, 1H), 3.54-3.49 (m, 1H), 1.98-1.95 (m, 4H), 1.84-1.69 (m, 9H), 1.41-1.18 (m, 10H), 1.15-1.06 (m, 4H), 1.02-0.80 (m, 13H).

Physical properties of compound (1ε-9-7) were as described below.

Transition temperature: C 33.6 S_{A} 101 I.

### Synthesis Example 11ε: Synthesis of Compound (1ε-9-8)

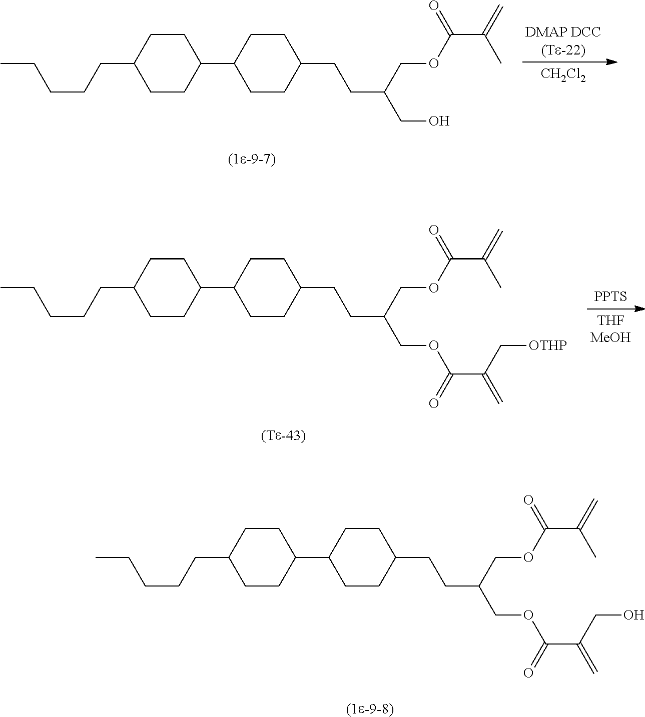

### First Step

Compound (Tε-43) (2.1 g; 74%) was obtained by using compound (1ε-9-7) (2.0 g) as a raw material in a manner similar to the technique in the third step in Synthesis Example 5ε.

### Second Step

Compound (1ε-9-8) (1.3 g; 72%) was obtained by using compound (Tε-43) (2.1 g) as a raw material in a manner similar to the technique in the fourth step in Synthesis Example 5E.

An NMR analysis value of the resulting compound (1ε-9-8) was as described below.

¹H-NMR: chemical shift δ (ppm; CDCl₃): 6.25 (s, 1H), 6.10 (s, 1H), 5.85 (d, J=1.1 Hz, 1H), 5.57 (s, 1H), 4.33 (d, J=6.5 Hz, 2H), 4.24-4.11 (m, 4H), 2.28 (t, J=6.6 Hz, 1H), 2.09-2.03 (m, 1H), 1.94 (s, 3H), 1.75-1.67 (m, 8H), 1.44-1.39 (m, 2H), 1.32-1.18 (m, 8H), 1.15-1.06 (m, 4H), 1.02-0.79 (m, 13H).

Physical properties of compound (1ε-9-8) were as described below.

Transition temperature: C 71.4 I.

### Synthesis Example 12ε: Synthesis of Compound (1ε-10-1)

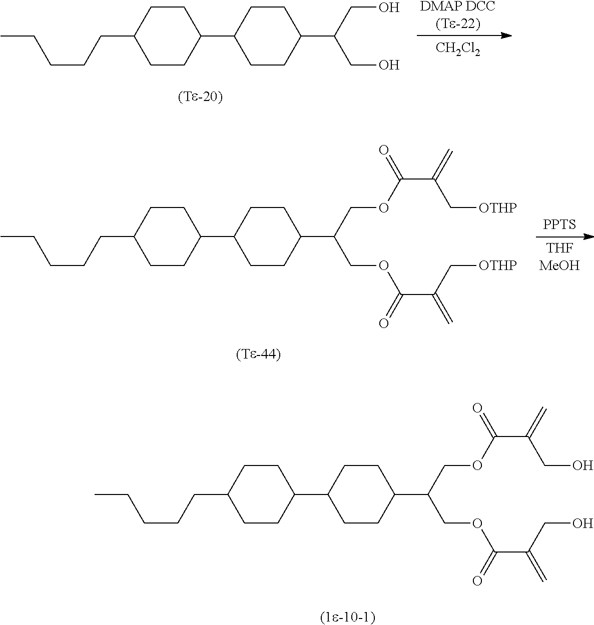

### First Step

Compound (Tε-20) (2.0 g), compound (Tε-22) (2.63 g), DMAP (0.78 g) and dichloromethane (100 mL) were put in a reaction vessel, and the resulting mixture was cooled down to 0° C. A dichloromethane (60 mL) solution of DCC (2.92 g) was slowly added dropwise thereto, and the resulting mixture was stirred for 12 hours while returning to room temperature. An insoluble matter was filtered off, and then the resulting reaction mixture was poured into water, and an aqueous layer was subjected to extraction with dichloromethane. A combined organic layer was washed with water and dried over anhydrous magnesium sulfate. The solution was concentrated under reduced pressure, and the residue was purified by silica gel chromatography (toluene:ethyl acetate=9:1 in a volume ratio) to obtain compound (Tε-44) (2.83 g; 68%).

### Second Step

Compound (Tε-44) (2.83 g), pyridinium p-toluenesulfonate (PPTS) (1.09 g), THF (50 mL) and methanol (50 mL) were put in a reaction vessel, and the resulting mixture was stirred at 50° C. for 8 hours. An insoluble matter was filtered off, and then the resulting reaction mixture was poured into water, and an aqueous layer was subjected to extraction with ethyl acetate. A combined organic layer was washed with water and dried over anhydrous magnesium sulfate. The solution was concentrated under reduced pressure, and the residue was purified by silica gel chromatography (toluene:ethyl acetate=1:1 in a volume ratio) to obtain compound (1ε-10-1) (1.47 g; 70%).

An NMR analysis value of the resulting compound (1ε-10-1) was as described below.

¹H-NMR: chemical shift δ (ppm; CDCl₃): 6.24 (s, 2H), 5.82 (s, 2H), 4.35-4.31 (m, 6H), 4.22-4.19 (m, 2H), 2.36 (s, 2H), 1.97-1.91 (s, 1H), 1.82-1.63 (m, 8H), 1.43-1.18 (m, 7H), 1.15-0.79 (m, 16H).

Physical properties of compound (1ε-10-1) were as described below.

Transition temperature: C 102 I.

### Synthesis Example 13ε: Synthesis of Compound (1ε-10-2)

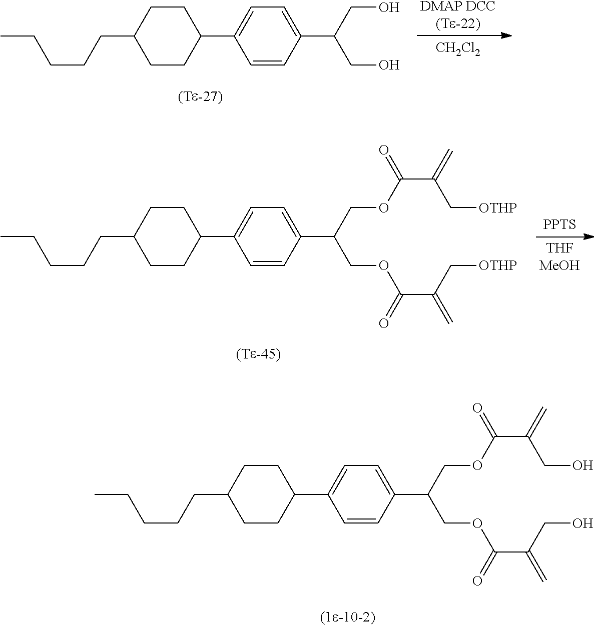

### First Step

Compound (Tε-45) (2.7 g; 64%) was obtained by using compound (Tε-27) (2.0 g) as a raw material in a manner similar to the technique in the first step in Synthesis Example 12ε.

### Second Step

Compound (1ε-10-2) (1.3 g; 65%) was obtained by using compound compound (Tε-45) (2.7 g) as a raw material in a manner similar to the technique in the second step in Synthesis Example 12ε.

An NMR analysis value of the resulting compound (1ε-10-2) was as described below.

¹H-NMR: chemical shift δ (ppm; CDCl₃): 7.20-7.16 (m, 4H), 6.26 (s, 2H), 5.83 (d, J=0.8 Hz, 2H), 4.46 (d, J=6.6 Hz, 4H), 4.28 (d, J=6.3 Hz, 4H), 3.44-3.39 (m, 1H), 2.44 (tt, J=12.2 Hz, J=3.1 Hz, 1H), 2.16-2.13 (m, 2H), 1.87-1.85 (m, 4H), 1.46-1.19 (m, 11H), 1.07-0.99 (m, 2H), 0.89 (t, J=6.8 Hz, 3H).

Physical properties of compound (1ε-10-2) were as described below.

Transition temperature: C 65.8 I.

### Synthesis Example 14ε: Synthesis of Compound (1ε-10-3)

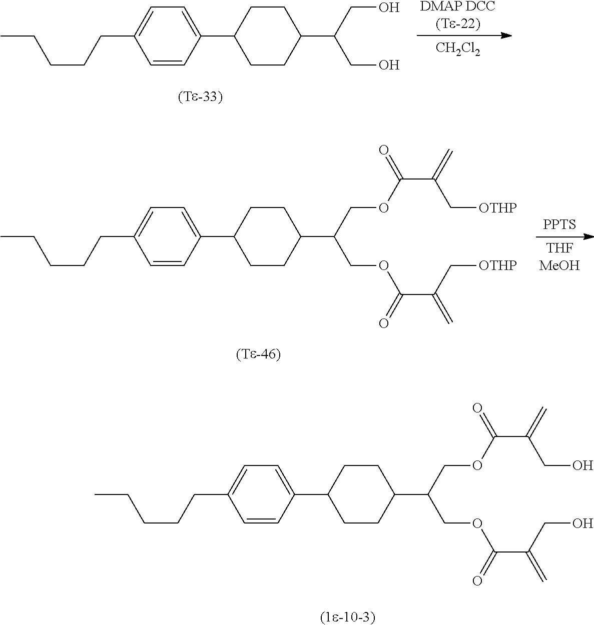

### First Step

Compound (Tε-46) (2.5 g; 59%) was obtained by using compound (Tε-33) (2.0 g) as a raw material in a manner similar to the technique in the first step in Synthesis Example 12ε.

### Second Step

Compound (1ε-10-3) (1.1 g; 60%) was obtained by using compound compound (Tε-46) (2.7 g) as a raw material in a manner similar to the technique in the second step in Synthesis Example 12ε.

An NMR analysis value of the resulting compound (1ε-10-3) was as described below.

¹H-NMR: chemical shift δ (ppm; CDCl₃): 7.14-7.10 (m, 4H), 6.27 (s, 2H), 5.87 (d, J=1.1 Hz, 2H), 4.39-4.33 (m, 6H), 4.27-4.20 (m, 2H), 2.57-2.54 (m, 2H), 2.45 (tt, J=12.2 Hz, J=3.1 Hz, 1H), 2.38-2.35 (m, 2H), 2.05-1.91 (m, 5H), 1.63-1.1.26 (m, 11H), 0.88 (t, J=6.8 Hz, 3H).

Physical properties of compound (1ε-10-3) were as described below.

Transition temperature: C 65.6 I.

### Synthesis Example 15ε: Synthesis of Compound (1ε-10-4)

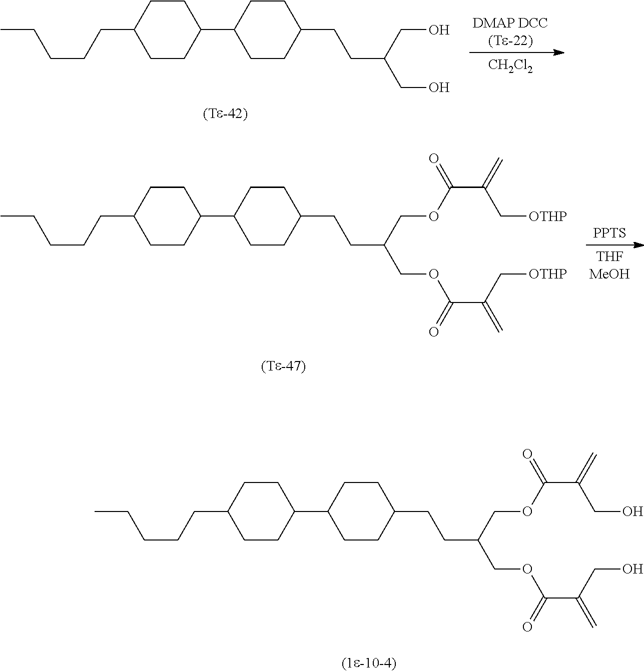

### First Step

Compound (Tε-47) (2.7 g; 67%) was obtained by using compound (Tε-42) (2.0 g) as a raw material in a manner similar to the technique in the first step in Synthesis Example 12ε.

### Second Step

Compound (1ε-10-4) (1.3 g; 64%) was obtained by using compound compound (Tε-47) (2.7 g) as a raw material in a manner similar to the technique in the second step in Synthesis Example 12ε.

An NMR analysis value of the resulting compound (1ε-10-4) was as described below.

¹H-NMR: chemical shift δ (ppm; CDCl₃): 6.25 (s, 2H), 5.85 (d, J=1.1 Hz, 2H), 4.33 (d, J=6.3 Hz, 4H), 4.25-4.22 (m, 2H), 4.18-4.14 (m, 2H), 2.30-2.28 (m, 2H), 2.11-2.06 (m, 1H), 1.75-1.67 (m, 8H), 1.44-1.39 (m, 2H), 1.32-0.79 (m, 25H).

Physical properties of compound (1ε-10-4) were as described below.

Transition temperature: C 85.7 S_{A} 125 I.

### 14. Example of Compound (1α)

According to the synthesis methods described in Synthesis Examples, compounds (1α-3-1) to (1α-3-40), compounds (1α-4-1) to (1α-4-120), compounds (1α-5-1) to (1α-5-140) and compounds (1α-6-1) to (1α-6-260) shown below can be prepared.

| No. | |
|---|---|
| 1α-3-1 | 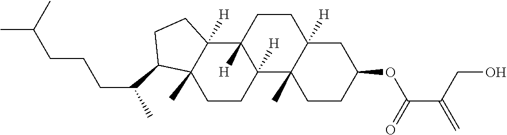 |
| 1α-3-2 | 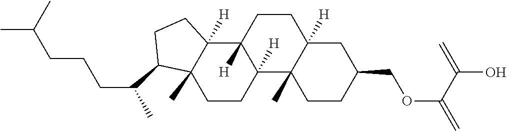 |
| 1α-3-3 | 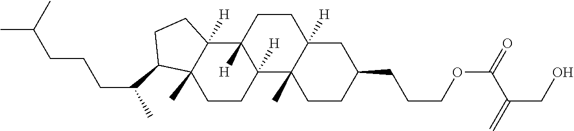 |
| 1α-3-4 | 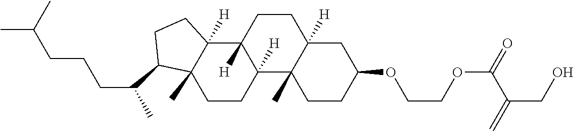 |
| 1α-3-5 | 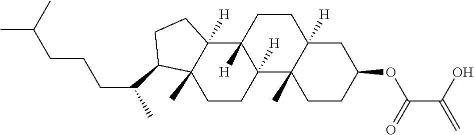 |
| 1α-3-6 | 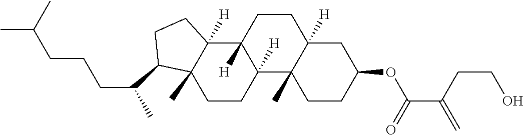 |
| 1α-3-7 | 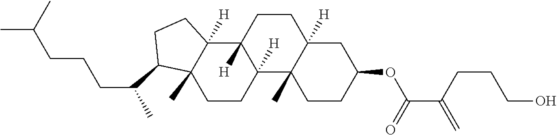 |
| 1α-3-8 | 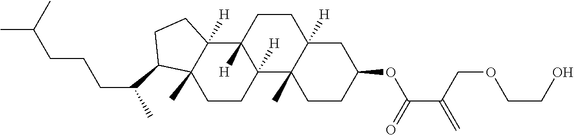 |
| 1α-3-9 | 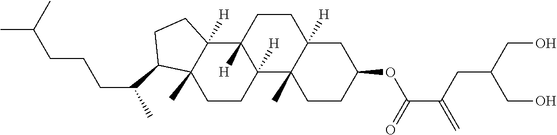 |
| 1α-3-10 | 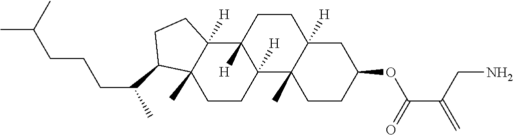 |
| 1α-3-11 | 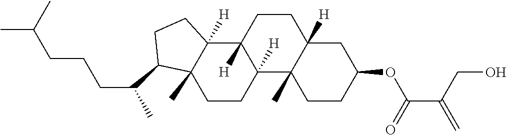 |
| 1α-3-12 | 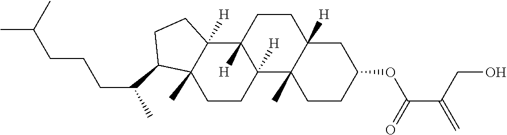 |
| 1α-3-13 | 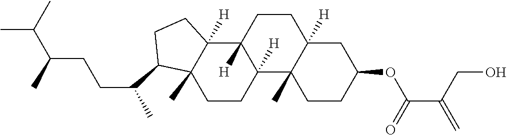 |
| 1α-3-14 | 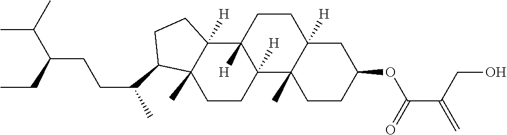 |
| 1α-3-15 | 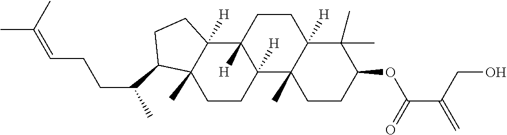 |
| 1α-3-16 | 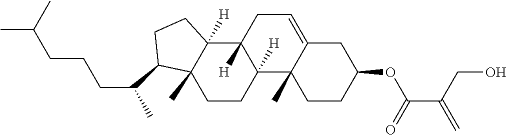 |
| 1α-3-17 | 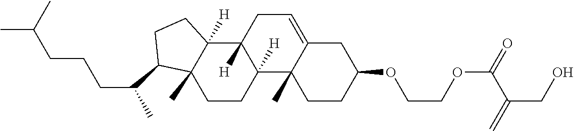 |
| 1α-3-18 | 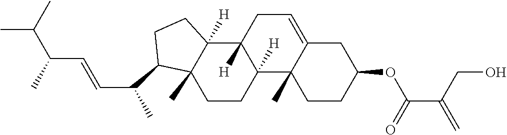 |
| 1α-3-19 | 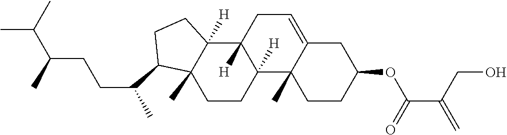 |
| 1α-3-20 | 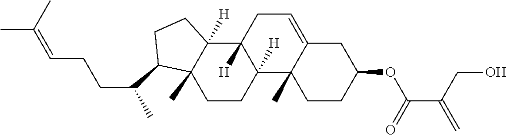 |
| 1α-3-21 | 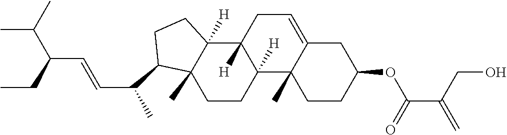 |
| 1α-3-22 | 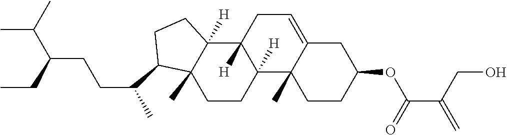 |
| 1α-3-23 | 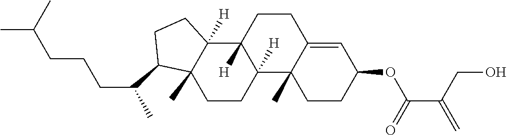 |
| 1α-3-24 | 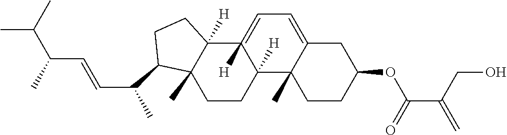 |
| 1α-3-25 | 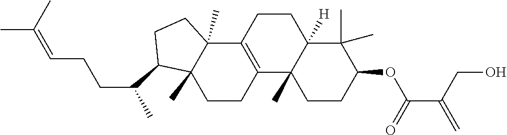 [SMILES: C=C(CO)C(=O)O[C@H]1CC[C@]2(C)C3=C(CC[C@H]2C1(C)C)[C@]1(C)CC[C@H]([C@H](C)CCC=C(C)C)[C@@]1(C)CC3] |
| 1α-3-26 | 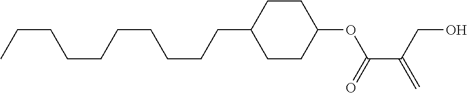 [SMILES: C=C(CO)C(=O)OC1CCC(CCCCCCCCCC)CC1] |
| 1α-3-27 | 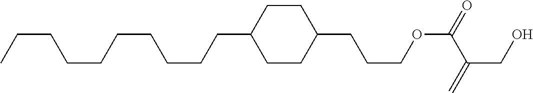 [SMILES: C=C(CO)C(=O)OCCCC1CCC(CCCCCCCCCC)CC1] |
| 1α-3-28 | 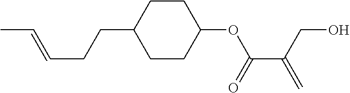 [SMILES: C=C(CO)C(=O)OC1CCC(CC/C=C/C)CC1] |
| 1α-3-29 | 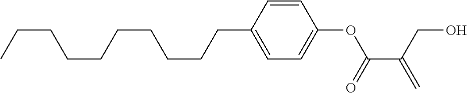 [SMILES: C=C(CO)C(=O)Oc1ccc(CCCCCCCCCC)cc1] |
| 1α-3-30 | 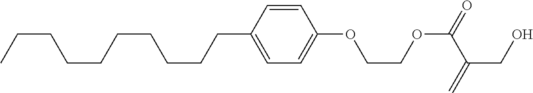 [SMILES: C=C(CO)C(=O)OCCOc1ccc(CCCCCCCCCC)cc1] |
| 1α-3-31 | 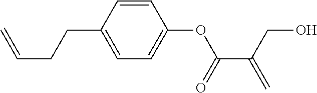 [SMILES: C=CCCc1ccc(OC(=O)C(=C)CO)cc1] |
| 1α-3-32 | 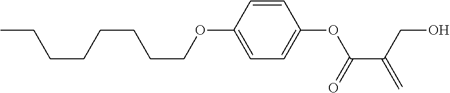 [SMILES: C=C(CO)C(=O)Oc1ccc(OCCCCCCCC)cc1] |
| 1α-3-33 | 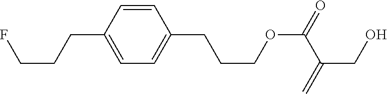 [SMILES: C=C(CO)C(=O)OCCCc1ccc(CCCF)cc1] |
| 1α-3-34 | 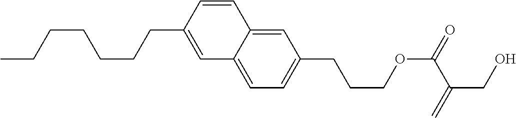 [SMILES: C=C(CO)C(=O)OCCCc1ccc2cc(CCCCCCC)ccc2c1] |
| 1α-3-35 | 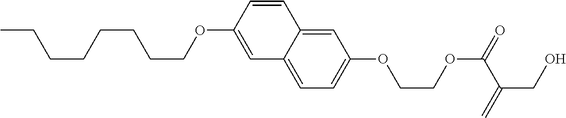 [SMILES: C=C(CO)C(=O)OCCOc1ccc2cc(OCCCCCCCC)ccc2c1] |
| 1α-3-36 | 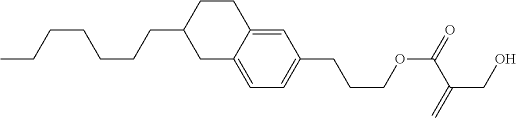 [SMILES: C=C(CO)C(=O)OCCCc1ccc2c(c1)CCC(CCCCCCC)C2] |
| 1α-3-37 | 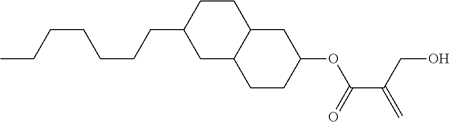 [SMILES: C=C(CO)C(=O)OC1CCC2CC(CCCCCCC)CCC2C1] |
| 1α-3-38 | 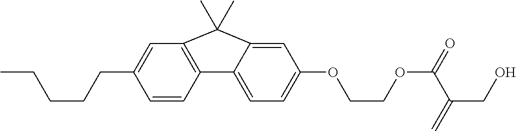 [SMILES: C=C(CO)C(=O)OCCOc1ccc2c(c1)C(C)(C)c1cc(CCCCC)ccc1-2] |
| 1α-3-39 | 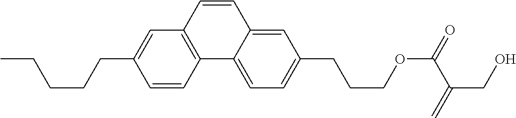 [SMILES: C=C(CO)C(=O)OCCCc1ccc2c(ccc3cc(CCCCC)ccc32)c1] |
| 1α-3-40 | 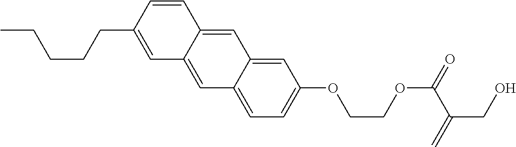 [SMILES: C=C(CO)C(=O)OCCOc1ccc2cc3cc(CCCCC)ccc3cc2c1] |
| 1α-4-1 | 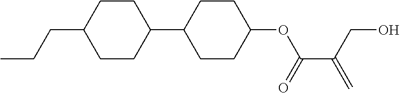 [SMILES: C=C(CO)C(=O)OC1CCC(C2CCC(CCC)CC2)CC1] |
| 1α-4-2 | 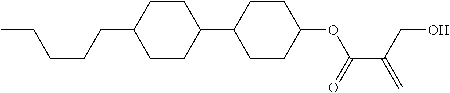 [SMILES: C=C(CO)C(=O)OC1CCC(C2CCC(CCCCC)CC2)CC1] |
| 1α-4-3 | 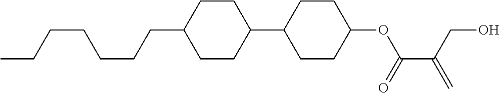 [SMILES: C=C(CO)C(=O)OC1CCC(C2CCC(CCCCCCC)CC2)CC1] |
| 1α-4-4 | 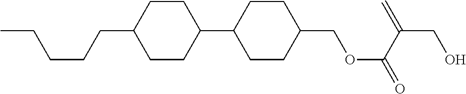 [SMILES: C=C(CO)C(=O)OCC1CCC(C2CCC(CCCCC)CC2)CC1] |
| 1α-4-5 | 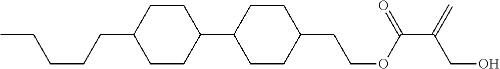 [SMILES: C=C(CO)C(=O)OCCC1CCC(C2CCC(CCCCC)CC2)CC1] |
| 1α-4-6 | 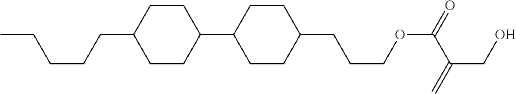 [SMILES: C=C(CO)C(=O)OCCCC1CCC(C2CCC(CCCCC)CC2)CC1] |
| 1α-4-7 | 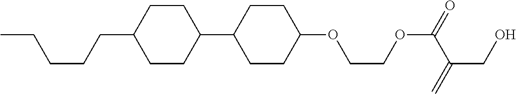 [SMILES: C=C(CO)C(=O)OCCOC1CCC(C2CCC(CCCCC)CC2)CC1] |
| 1α-4-8 | 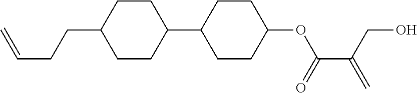 [SMILES: C=CCCC1CCC(C2CCC(OC(=O)C(=C)CO)CC2)CC1] |
| 1α-4-9 | 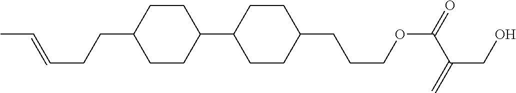 [SMILES: C=C(CO)C(=O)OCCCC1CCC(C2CCC(CC/C=C/C)CC2)CC1] |
| 1α-4-10 | 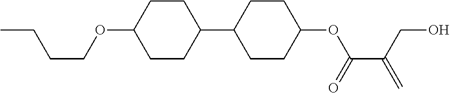 [SMILES: C=C(CO)C(=O)OC1CCC(C2CCC(OCCCC)CC2)CC1] |
| 1α-4-11 | 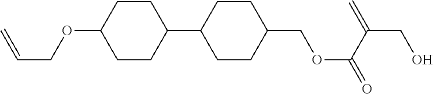 [SMILES: C=CCOC1CCC(C2CCC(COC(=O)C(=C)CO)CC2)CC1] |
| 1α-4-12 | 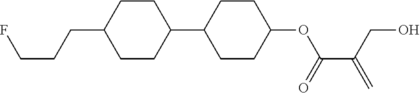 [SMILES: C=C(CO)C(=O)OC1CCC(C2CCC(CCCF)CC2)CC1] |
| 1α-4-13 | 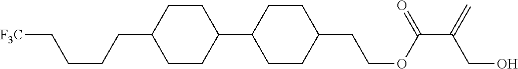 [SMILES: C=C(CO)C(=O)OCCC1CCC(C2CCC(CCCCC(F)(F)F)CC2)CC1] |
| 1α-4-14 | 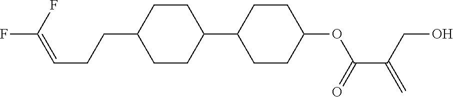 [SMILES: C=C(CO)C(=O)OC1CCC(C2CCC(CCC=C(F)F)CC2)CC1] |
| 1α-4-15 | 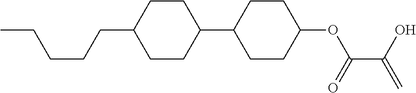 [SMILES: C=C(O)C(=O)OC1CCC(C2CCC(CCCCC)CC2)CC1] |
| 1α-4-16 | 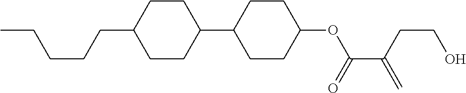 [SMILES: C=C(CCO)C(=O)OC1CCC(C2CCC(CCCCC)CC2)CC1] |
| 1α-4-17 | 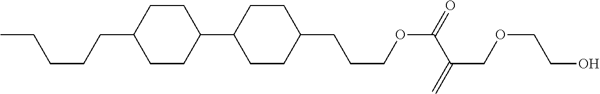 [SMILES: C=C(COCCO)C(=O)OCCCC1CCC(C2CCC(CCCCC)CC2)CC1] |
| 1α-4-18 | 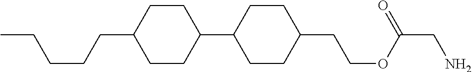 [SMILES: CCCCCC1CCC(C2CCC(CCOC(=O)CN)CC2)CC1] |
| 1α-4-19 | 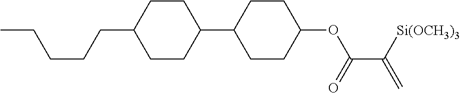 |
| 1α-4-20 | 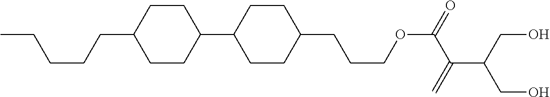 [SMILES: C=C(C(=O)OCCCC1CCC(C2CCC(CCCCC)CC2)CC1)C(CO)CO] |
| 1α-4-21 | 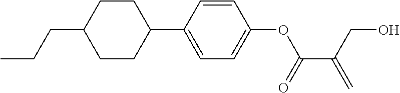 [SMILES: C=C(CO)C(=O)Oc1ccc(C2CCC(CCC)CC2)cc1] |
| 1α-4-22 | 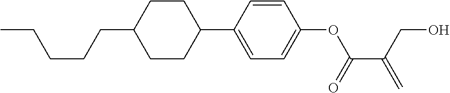 [SMILES: C=C(CO)C(=O)Oc1ccc(C2CCC(CCCCC)CC2)cc1] |
| 1α-4-23 | 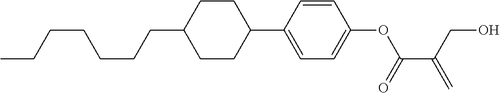 [SMILES: C=C(CO)C(=O)Oc1ccc(C2CCC(CCCCCCC)CC2)cc1] |
| 1α-4-24 | 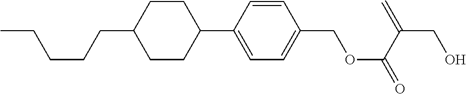 [SMILES: C=C(CO)C(=O)OCc1ccc(C2CCC(CCCCC)CC2)cc1] |
| 1α-4-25 | 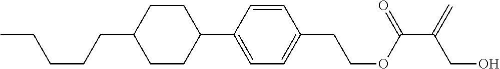 [SMILES: C=C(CO)C(=O)OCCc1ccc(C2CCC(CCCCC)CC2)cc1] |
| 1α-4-26 | 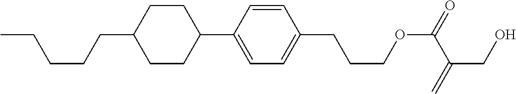 [SMILES: C=C(CO)C(=O)OCCCc1ccc(C2CCC(CCCCC)CC2)cc1] |
| 1α-4-27 | 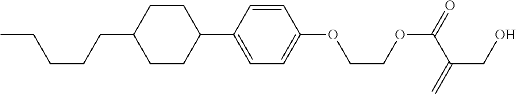 [SMILES: C=C(CO)C(=O)OCCOc1ccc(C2CCC(CCCCC)CC2)cc1] |
| 1α-4-28 | 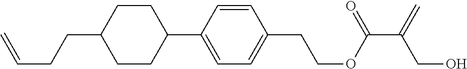 [SMILES: C=CCCC1CCC(c2ccc(CCOC(=O)C(=C)CO)cc2)CC1] |
| 1α-4-29 | 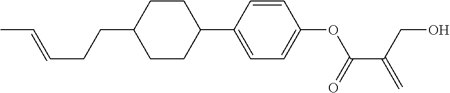 [SMILES: C=C(CO)C(=O)Oc1ccc(C2CCC(CC/C=C/C)CC2)cc1] |
| 1α-4-30 | 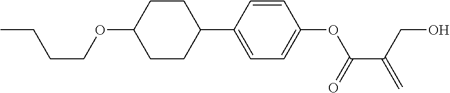 [SMILES: C=C(CO)C(=O)Oc1ccc(C2CCC(OCCCC)CC2)cc1] |
| 1α-4-31 | 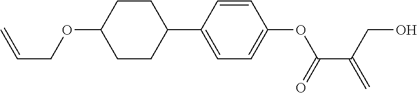 [SMILES: C=CCOC1CCC(c2ccc(OC(=O)C(=C)CO)cc2)CC1] |
| 1α-4-32 | 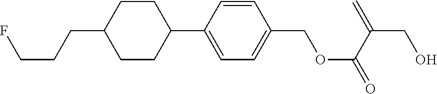 [SMILES: C=C(CO)C(=O)OCc1ccc(C2CCC(CCCF)CC2)cc1] |
| 1α-4-33 | 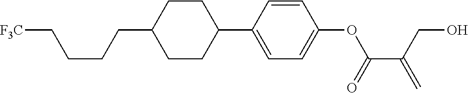 [SMILES: C=C(CO)C(=O)Oc1ccc(C2CCC(CCCCC(F)(F)F)CC2)cc1] |
| 1α-4-34 | 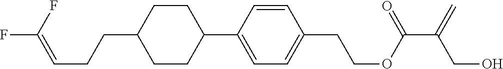 [SMILES: C=C(CO)C(=O)OCCc1ccc(C2CCC(CCC=C(F)F)CC2)cc1] |
| 1α-4-35 | 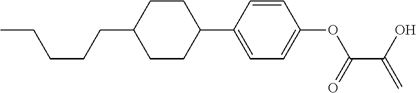 [SMILES: C=C(O)C(=O)Oc1ccc(C2CCC(CCCCC)CC2)cc1] |
| 1α-4-36 | 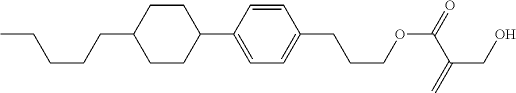 [SMILES: C=C(CO)C(=O)OCCCc1ccc(C2CCC(CCCCC)CC2)cc1] |
| 1α-4-37 | 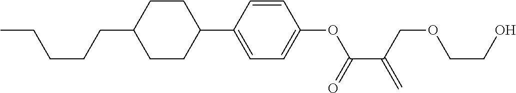 [SMILES: C=C(COCCO)C(=O)Oc1ccc(C2CCC(CCCCC)CC2)cc1] |
| 1α-4-38 | 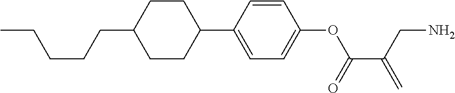 [SMILES: C=C(CN)C(=O)Oc1ccc(C2CCC(CCCCC)CC2)cc1] |
| 1α-4-39 | 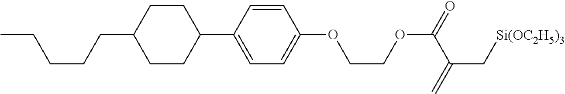 |
| 1α-4-40 | 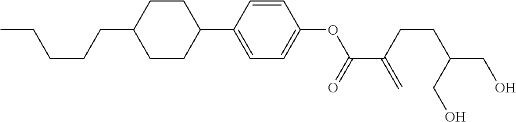 [SMILES: C=C(CCC(CO)CO)C(=O)Oc1ccc(C2CCC(CCCCC)CC2)cc1] |
| 1α-4-41 | 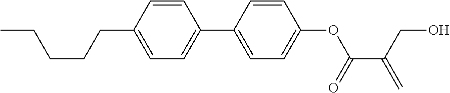 [SMILES: C=C(CO)C(=O)Oc1ccc(-c2ccc(CCCCC)cc2)cc1] |
| 1α-4-42 | 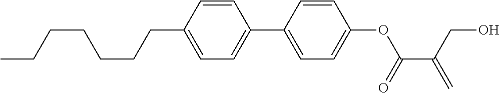 [SMILES: C=C(CO)C(=O)Oc1ccc(-c2ccc(CCCCCCC)cc2)cc1] |
| 1α-4-43 | 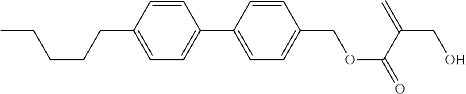 [SMILES: C=C(CO)C(=O)OCc1ccc(-c2ccc(CCCCC)cc2)cc1] |
| 1α-4-44 | 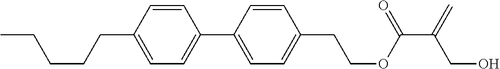 [SMILES: C=C(CO)C(=O)OCCc1ccc(-c2ccc(CCCCC)cc2)cc1] |
| 1α-4-45 | 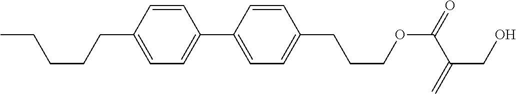 [SMILES: C=C(CO)C(=O)OCCCc1ccc(-c2ccc(CCCCC)cc2)cc1] |
| 1α-4-46 | 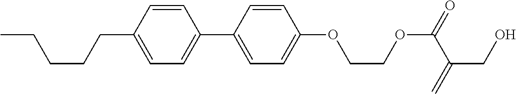 [SMILES: C=C(CO)C(=O)OCCOc1ccc(-c2ccc(CCCCC)cc2)cc1] |
| 1α-4-47 | 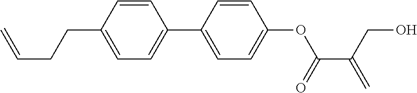 [SMILES: C=CCCc1ccc(-c2ccc(OC(=O)C(=C)CO)cc2)cc1] |
| 1α-4-48 | 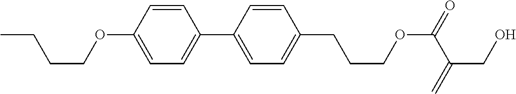 [SMILES: C=C(CO)C(=O)OCCCc1ccc(-c2ccc(OCCCC)cc2)cc1] |
| 1α-4-49 | 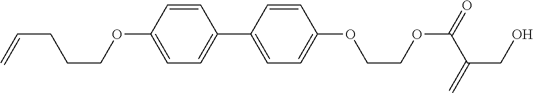 [SMILES: C=CCCCOc1ccc(-c2ccc(OCCOC(=O)C(=C)CO)cc2)cc1] |
| 1α-4-50 | 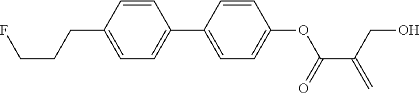 [SMILES: C=C(CO)C(=O)Oc1ccc(-c2ccc(CCCF)cc2)cc1] |
| 1α-4-51 | 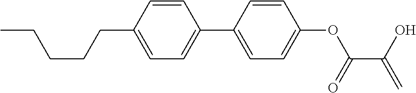 [SMILES: C=C(O)C(=O)Oc1ccc(-c2ccc(CCCCC)cc2)cc1] |
| 1α-4-52 | 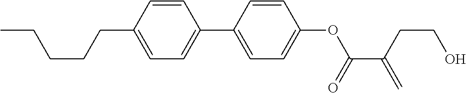 [SMILES: C=C(CCO)C(=O)Oc1ccc(-c2ccc(CCCCC)cc2)cc1] |
| 1α-4-53 | 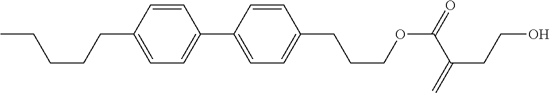 [SMILES: C=C(CCO)C(=O)OCCCc1ccc(-c2ccc(CCCCC)cc2)cc1] |
| 1α-4-54 | 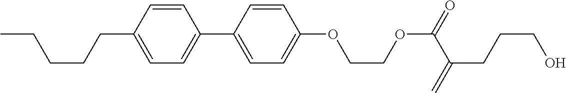 [SMILES: C=C(CCCO)C(=O)OCCOc1ccc(-c2ccc(CCCCC)cc2)cc1] |
| 1α-4-55 | 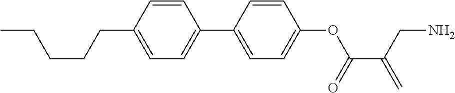 [SMILES: C=C(CN)C(=O)Oc1ccc(-c2ccc(CCCCC)cc2)cc1] |
| 1α-4-56 | 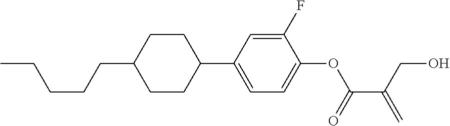 [SMILES: C=C(CO)C(=O)Oc1ccc(C2CCC(CCCCC)CC2)cc1F] |
| 1α-4-57 | 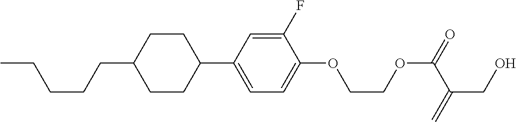 [SMILES: C=C(CO)C(=O)OCCOc1ccc(C2CCC(CCCCC)CC2)cc1F] |
| 1α-4-58 | 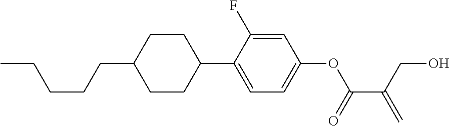 [SMILES: C=C(CO)C(=O)Oc1ccc(C2CCC(CCCCC)CC2)c(F)c1] |
| 1α-4-59 | 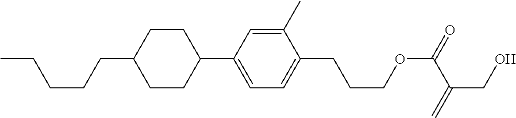 [SMILES: C=C(CO)C(=O)OCCCc1ccc(C2CCC(CCCCC)CC2)cc1C] |
| 1α-4-60 | 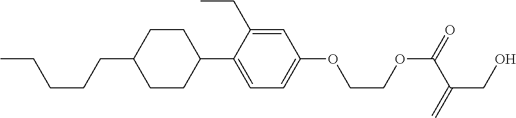 [SMILES: C=C(CO)C(=O)OCCOc1ccc(C2CCC(CCCCC)CC2)c(CC)c1] |
| 1α-4-61 | 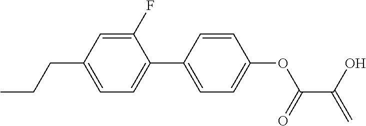 [SMILES: C=C(O)C(=O)Oc1ccc(-c2ccc(CCC)cc2F)cc1] |
| 1α-4-62 | 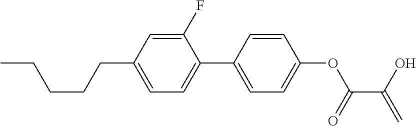 [SMILES: C=C(O)C(=O)Oc1ccc(-c2ccc(CCCCC)cc2F)cc1] |
| 1α-4-63 | 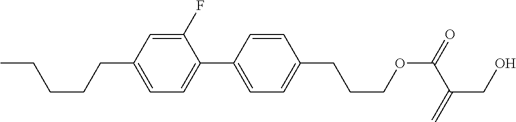 [SMILES: C=C(CO)C(=O)OCCCc1ccc(-c2ccc(CCCCC)cc2F)cc1] |
| 1α-4-64 | 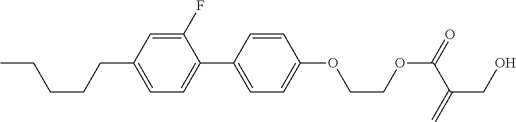 [SMILES: C=C(CO)C(=O)OCCOc1ccc(-c2ccc(CCCCC)cc2F)cc1] |
| 1α-4-65 | 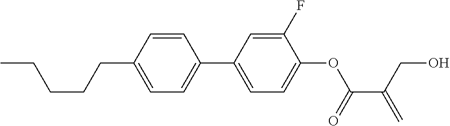 [SMILES: C=C(CO)C(=O)Oc1ccc(-c2ccc(CCCCC)cc2)cc1F] |
| 1α-4-66 | 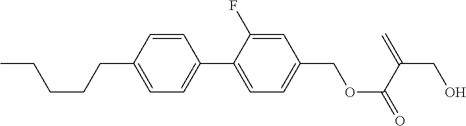 [SMILES: C=C(CO)C(=O)OCc1ccc(-c2ccc(CCCCC)cc2)c(F)c1] |
| 1α-4-67 | 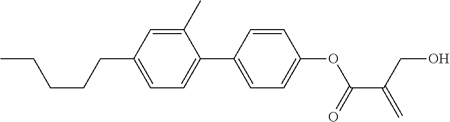 [SMILES: C=C(CO)C(=O)Oc1ccc(-c2ccc(CCCCC)cc2C)cc1] |
| 1α-4-68 | 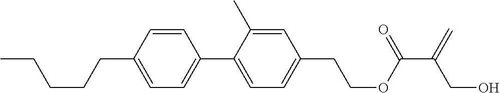 [SMILES: C=C(CO)C(=O)OCCc1ccc(-c2ccc(CCCCC)cc2)c(C)c1] |
| 1α-4-69 | 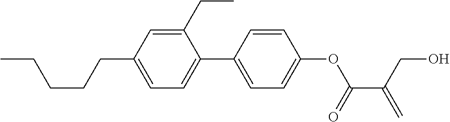 [SMILES: C=C(CO)C(=O)Oc1ccc(-c2ccc(CCCCC)cc2CC)cc1] |
| 1α-4-70 | 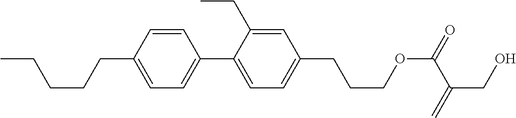 [SMILES: C=C(CO)C(=O)OCCCc1ccc(-c2ccc(CCCCC)cc2)c(CC)c1] |
| 1α-4-71 | 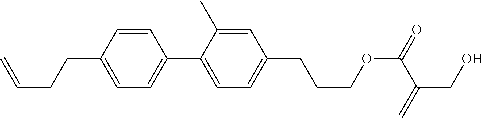 [SMILES: C=CCCc1ccc(-c2ccc(CCCOC(=O)C(=C)CO)cc2C)cc1] |
| 1α-4-72 | 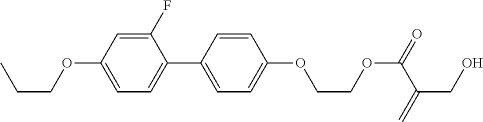 [SMILES: C=C(CO)C(=O)OCCOc1ccc(-c2ccc(OCCC)cc2F)cc1] |
| 1α-4-73 | 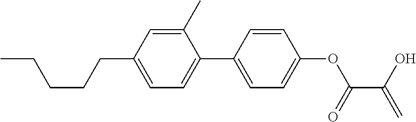 [SMILES: C=C(O)C(=O)Oc1ccc(-c2ccc(CCCCC)cc2C)cc1] |
| 1α-4-74 | 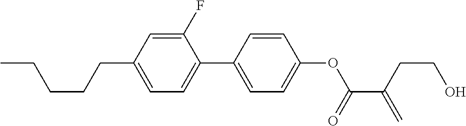 [SMILES: C=C(CCO)C(=O)Oc1ccc(-c2ccc(CCCCC)cc2F)cc1] |
| 1α-4-75 | 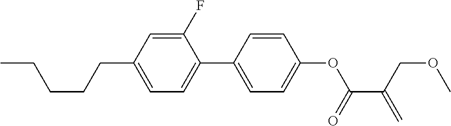 [SMILES: C=C(COC)C(=O)Oc1ccc(-c2ccc(CCCCC)cc2F)cc1] |
| 1α-4-76 | 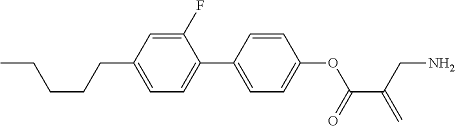 [SMILES: C=C(CN)C(=O)Oc1ccc(-c2ccc(CCCCC)cc2F)cc1] |
| 1α-4-77 | 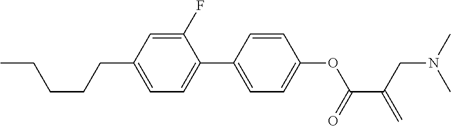 [SMILES: C=C(CN(C)C)C(=O)Oc1ccc(-c2ccc(CCCCC)cc2F)cc1] |
| 1α-4-78 | 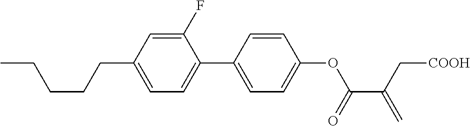 [SMILES: C=C(CC(=O)O)C(=O)Oc1ccc(-c2ccc(CCCCC)cc2F)cc1] |
| 1α-4-79 | 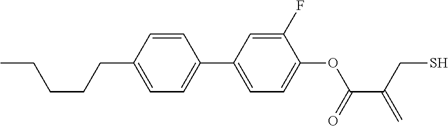 [SMILES: C=C(CS)C(=O)Oc1ccc(-c2ccc(CCCCC)cc2)cc1F] |
| 1α-4-80 | 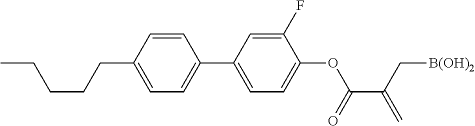 [SMILES: C=C(CB(O)O)C(=O)Oc1ccc(-c2ccc(CCCCC)cc2)cc1F] |
| 1α-4-81 | 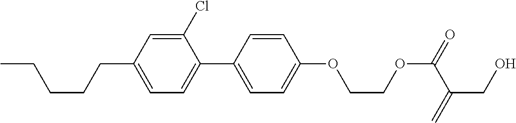 [SMILES: C=C(CO)C(=O)OCCOc1ccc(-c2ccc(CCCCC)cc2Cl)cc1] |
| 1α-4-82 | 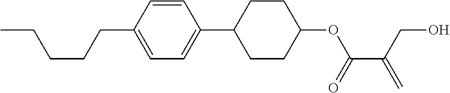 [SMILES: C=C(CO)C(=O)OC1CCC(c2ccc(CCCCC)cc2)CC1] |
| 1α-4-83 | 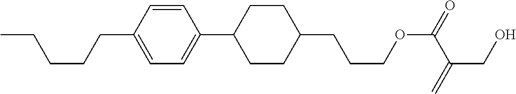 [SMILES: C=C(CO)C(=O)OCCCC1CCC(c2ccc(CCCCC)cc2)CC1] |
| 1α-4-84 | 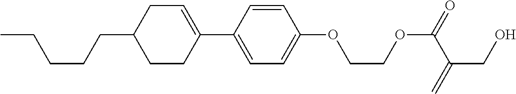 [SMILES: C=C(CO)C(=O)OCCOc1ccc(C2=CCC(CCCCC)CC2)cc1] |
| 1α-4-85 | 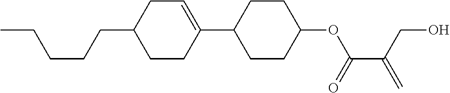 [SMILES: C=C(CO)C(=O)OC1CCC(C2=CCC(CCCCC)CC2)CC1] |
| 1α-4-86 | 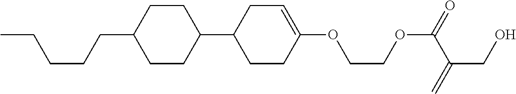 [SMILES: C=C(CO)C(=O)OCCOC1=CCC(C2CCC(CCCCC)CC2)CC1] |
| 1α-4-87 | 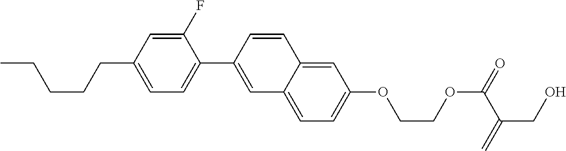 [SMILES: C=C(CO)C(=O)OCCOc1ccc2cc(-c3ccc(CCCCC)cc3F)ccc2c1] |
| 1α-4-88 | 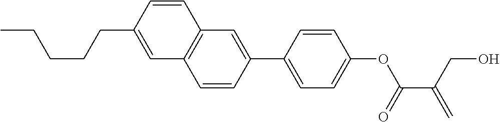 [SMILES: C=C(CO)C(=O)Oc1ccc(-c2ccc3cc(CCCCC)ccc3c2)cc1] |
| 1α-4-89 | 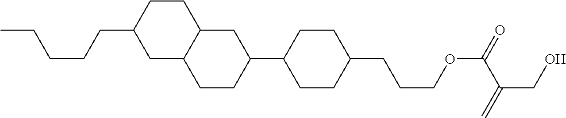 [SMILES: C=C(CO)C(=O)OCCCC1CCC(C2CCC3CC(CCCCC)CCC3C2)CC1] |
| 1α-4-90 | 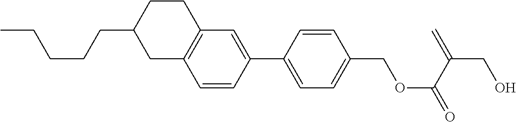 [SMILES: C=C(CO)C(=O)OCc1ccc(-c2ccc3c(c2)CCC(CCCCC)C3)cc1] |
| 1α-4-91 | 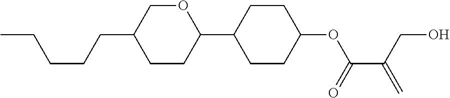 [SMILES: C=C(CO)C(=O)OC1CCC(C2CCC(CCCCC)CO2)CC1] |
| 1α-4-92 | 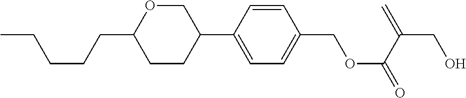 [SMILES: C=C(CO)C(=O)OCc1ccc(C2CCC(CCCCC)OC2)cc1] |
| 1α-4-93 | 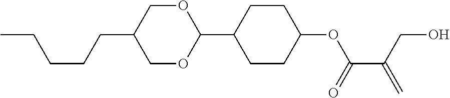 [SMILES: C=C(CO)C(=O)OC1CCC(C2OCC(CCCCC)CO2)CC1] |
| 1α-4-94 | 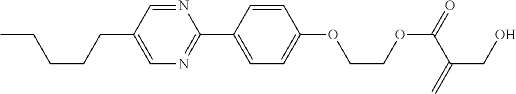 [SMILES: C=C(CO)C(=O)OCCOc1ccc(-c2ncc(CCCCC)cn2)cc1] |
| 1α-4-95 | 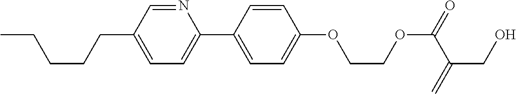 [SMILES: C=C(CO)C(=O)OCCOc1ccc(-c2ccc(CCCCC)cn2)cc1] |
| 1α-4-96 | 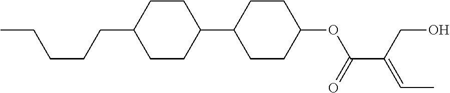 [SMILES: C/C=C(\CO)C(=O)OC1CCC(C2CCC(CCCCC)CC2)CC1] |
| 1α-4-97 | 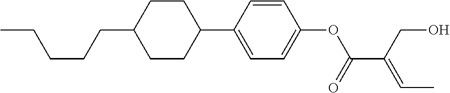 [SMILES: C/C=C(\CO)C(=O)Oc1ccc(C2CCC(CCCCC)CC2)cc1] |
| 1α-4-98 | 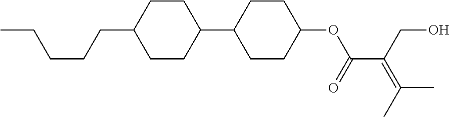 [SMILES: CCCCCC1CCC(C2CCC(OC(=O)C(CO)=C(C)C)CC2)CC1] |
| 1α-4-99 | 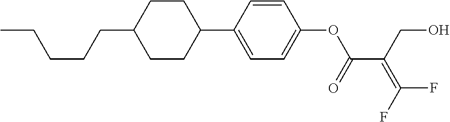 [SMILES: CCCCCC1CCC(c2ccc(OC(=O)C(CO)=C(F)F)cc2)CC1] |
| 1α-4-100 | 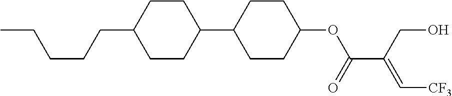 [SMILES: CCCCCC1CCC(C2CCC(OC(=O)/C(=C/C(F)(F)F)CO)CC2)CC1] |
| 1α-4-101 | 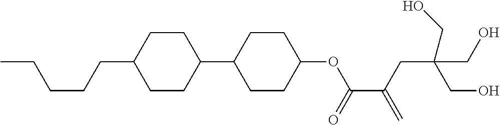 [SMILES: C=C(CC(CO)(CO)CO)C(=O)OC1CCC(C2CCC(CCCCC)CC2)CC1] |
| 1α-4-102 | 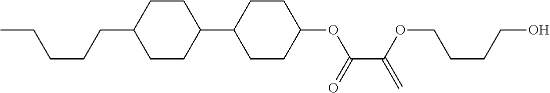 [SMILES: C=C(OCCCCO)C(=O)OC1CCC(C2CCC(CCCCC)CC2)CC1] |
| 1α-4-103 | 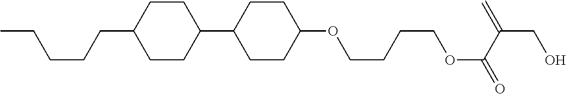 [SMILES: C=C(CO)C(=O)OCCCCOC1CCC(C2CCC(CCCCC)CC2)CC1] |
| 1α-4-104 | 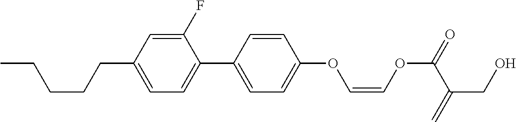 [SMILES: C=C(CO)C(=O)O/C=C\Oc1ccc(-c2ccc(CCCCC)cc2F)cc1] |
| 1α-4-105 | 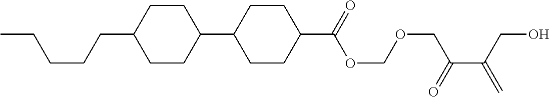 [SMILES: C=C(CO)C(=O)COCOC(=O)C1CCC(C2CCC(CCCCC)CC2)CC1] |
| 1α-4-106 | 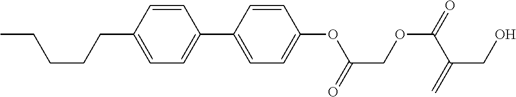 [SMILES: C=C(CO)C(=O)OCC(=O)Oc1ccc(-c2ccc(CCCCC)cc2)cc1] |
| 1α-4-107 | 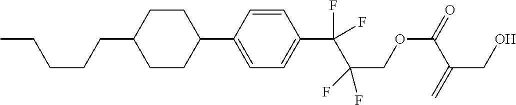 [SMILES: C=C(CO)C(=O)OCC(F)(F)C(F)(F)c1ccc(C2CCC(CCCCC)CC2)cc1] |
| 1α-4-108 | 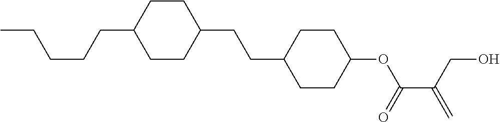 [SMILES: C=C(CO)C(=O)OC1CCC(CCC2CCC(CCCCC)CC2)CC1] |
| 1α-4-109 | 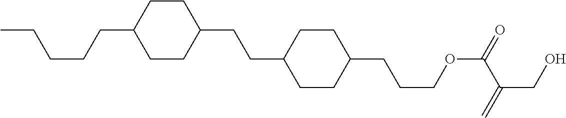 [SMILES: C=C(CO)C(=O)OCCCC1CCC(CCC2CCC(CCCCC)CC2)CC1] |
| 1α-4-110 | 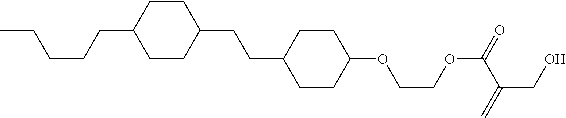 [SMILES: C=C(CO)C(=O)OCCOC1CCC(CCC2CCC(CCCCC)CC2)CC1] |
| 1α-4-111 | 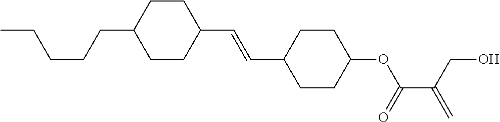 [SMILES: C=C(CO)C(=O)OC1CCC(/C=C/C2CCC(CCCCC)CC2)CC1] |
| 1α-4-112 | 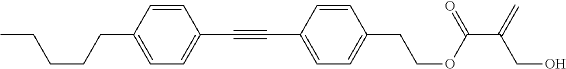 [SMILES: C=C(CO)C(=O)OCCc1ccc(C#Cc2ccc(CCCCC)cc2)cc1] |
| 1α-4-113 | 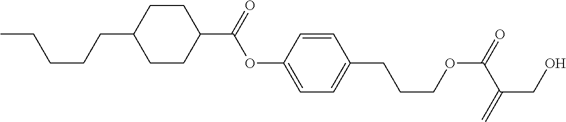 [SMILES: C=C(CO)C(=O)OCCCc1ccc(OC(=O)C2CCC(CCCCC)CC2)cc1] |
| 1α-4-114 | 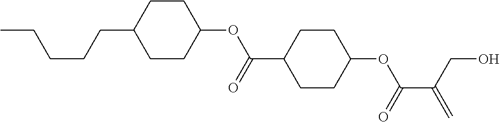 [SMILES: C=C(CO)C(=O)OC1CCC(C(=O)OC2CCC(CCCCC)CC2)CC1] |
| 1α-4-115 | 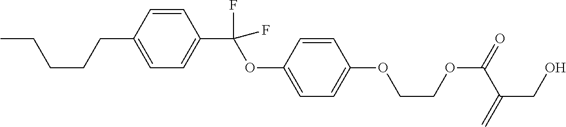 [SMILES: C=C(CO)C(=O)OCCOc1ccc(OC(F)(F)c2ccc(CCCCC)cc2)cc1] |
| 1α-4-116 | 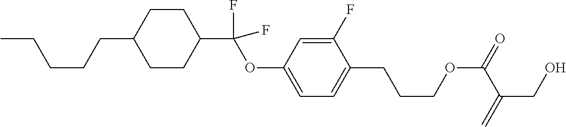 [SMILES: C=C(CO)C(=O)OCCCc1ccc(OC(F)(F)C2CCC(CCCCC)CC2)cc1F] |
| 1α-4-117 | 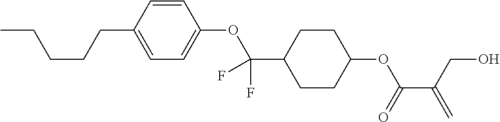 [SMILES: C=C(CO)C(=O)OC1CCC(C(F)(F)Oc2ccc(CCCCC)cc2)CC1] |
| 1α-4-118 | 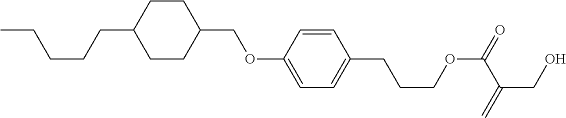 [SMILES: C=C(CO)C(=O)OCCCc1ccc(OCC2CCC(CCCCC)CC2)cc1] |
| 1α-4-119 | 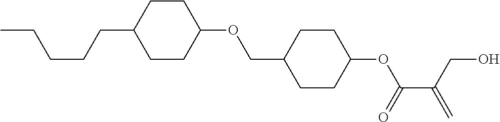 [SMILES: C=C(CO)C(=O)OC1CCC(COC2CCC(CCCCC)CC2)CC1] |
| 1α-4-120 | 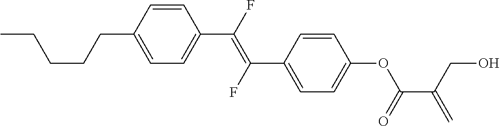 [SMILES: C=C(CO)C(=O)Oc1ccc(/C(F)=C(\F)c2ccc(CCCCC)cc2)cc1] |
| 1α-5-1 | 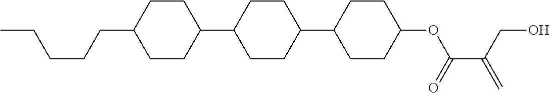 [SMILES: C=C(CO)C(=O)OC1CCC(C2CCC(C3CCC(CCCCC)CC3)CC2)CC1] |
| 1α-5-2 | 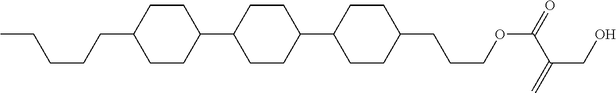 [SMILES: C=C(CO)C(=O)OCCCC1CCC(C2CCC(C3CCC(CCCCC)CC3)CC2)CC1] |
| 1α-5-3 | 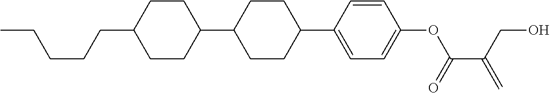 [SMILES: C=C(CO)C(=O)Oc1ccc(C2CCC(C3CCC(CCCCC)CC3)CC2)cc1] |
| 1α-5-4 | 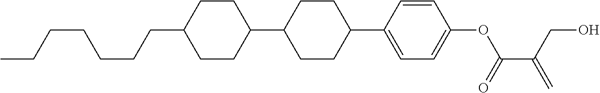 [SMILES: C=C(CO)C(=O)Oc1ccc(C2CCC(C3CCC(CCCCCCC)CC3)CC2)cc1] |
| 1α-5-5 | 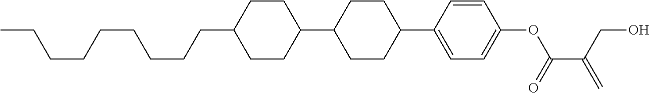 [SMILES: C=C(CO)C(=O)Oc1ccc(C2CCC(C3CCC(CCCCCCCCC)CC3)CC2)cc1] |
| 1α-5-6 | 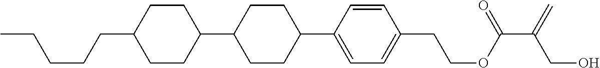 [SMILES: C=C(CO)C(=O)OCCc1ccc(C2CCC(C3CCC(CCCCC)CC3)CC2)cc1] |
| 1α-5-7 | 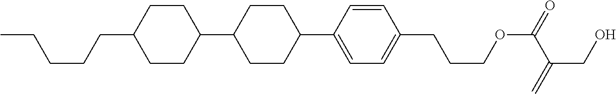 [SMILES: C=C(CO)C(=O)OCCCc1ccc(C2CCC(C3CCC(CCCCC)CC3)CC2)cc1] |
| 1α-5-8 | 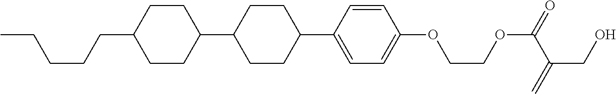 [SMILES: C=C(CO)C(=O)OCCOc1ccc(C2CCC(C3CCC(CCCCC)CC3)CC2)cc1] |
| 1α-5-9 | 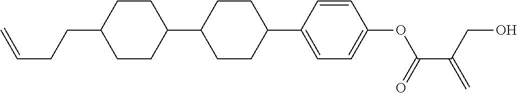 [SMILES: C=CCCC1CCC(C2CCC(c3ccc(OC(=O)C(=C)CO)cc3)CC2)CC1] |
| 1α-5-10 | 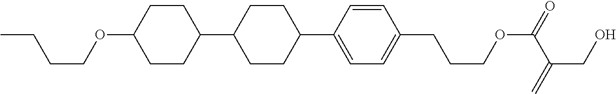 [SMILES: C=C(CO)C(=O)OCCCc1ccc(C2CCC(C3CCC(OCCCC)CC3)CC2)cc1] |
| 1α-5-11 | 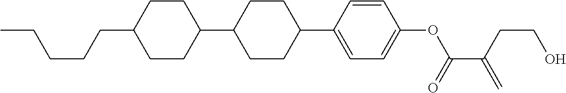 [SMILES: C=C(CCO)C(=O)Oc1ccc(C2CCC(C3CCC(CCCCC)CC3)CC2)cc1] |
| 1α-5-12 | 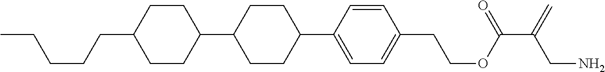 [SMILES: C=C(CN)C(=O)OCCc1ccc(C2CCC(C3CCC(CCCCC)CC3)CC2)cc1] |
| 1α-5-13 | 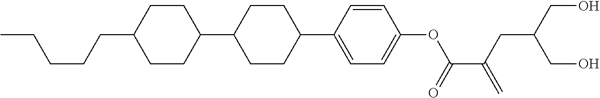 [SMILES: C=C(CC(CO)CO)C(=O)Oc1ccc(C2CCC(C3CCC(CCCCC)CC3)CC2)cc1] |
| 1α-5-14 | 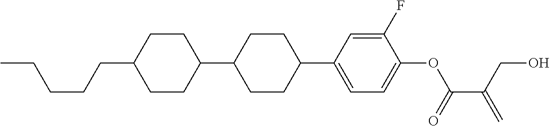 [SMILES: C=C(CO)C(=O)Oc1ccc(C2CCC(C3CCC(CCCCC)CC3)CC2)cc1F] |
| 1α-5-15 | 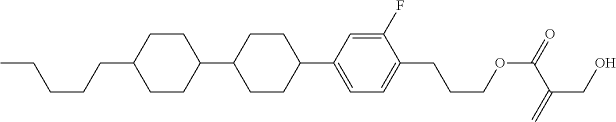 [SMILES: C=C(CO)C(=O)OCCCc1ccc(C2CCC(C3CCC(CCCCC)CC3)CC2)cc1F] |
| 1α-5-16 | 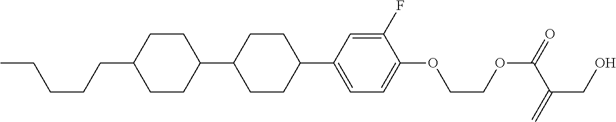 [SMILES: C=C(CO)C(=O)OCCOc1ccc(C2CCC(C3CCC(CCCCC)CC3)CC2)cc1F] |
| 1α-5-17 | 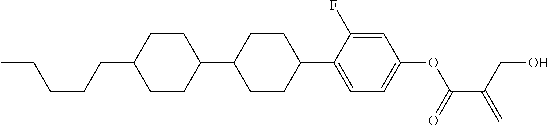 [SMILES: C=C(CO)C(=O)Oc1ccc(C2CCC(C3CCC(CCCCC)CC3)CC2)c(F)c1] |
| 1α-5-18 | 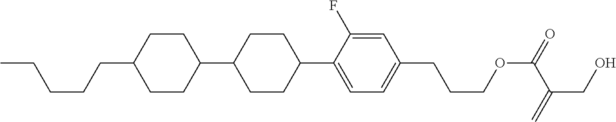 [SMILES: C=C(CO)C(=O)OCCCc1ccc(C2CCC(C3CCC(CCCCC)CC3)CC2)c(F)c1] |
| 1α-5-19 | 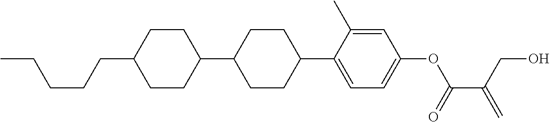 [SMILES: C=C(CO)C(=O)Oc1ccc(C2CCC(C3CCC(CCCCC)CC3)CC2)c(C)c1] |
| 1α-5-20 | 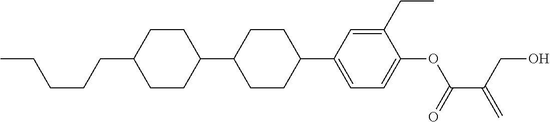 [SMILES: C=C(CO)C(=O)Oc1ccc(C2CCC(C3CCC(CCCCC)CC3)CC2)cc1CC] |
| 1α-5-21 | 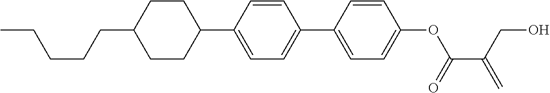 [SMILES: C=C(CO)C(=O)Oc1ccc(-c2ccc(C3CCC(CCCCC)CC3)cc2)cc1] |
| 1α-5-22 | 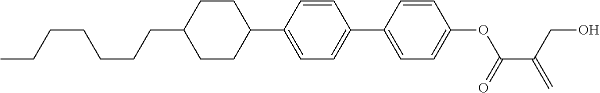 [SMILES: C=C(CO)C(=O)Oc1ccc(-c2ccc(C3CCC(CCCCCCC)CC3)cc2)cc1] |
| 1α-5-23 | 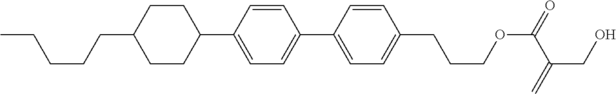 [SMILES: C=C(CO)C(=O)OCCCc1ccc(-c2ccc(C3CCC(CCCCC)CC3)cc2)cc1] |
| 1α-5-24 | 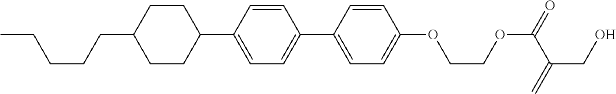 [SMILES: C=C(CO)C(=O)OCCOc1ccc(-c2ccc(C3CCC(CCCCC)CC3)cc2)cc1] |
| 1α-5-25 | 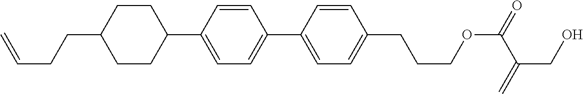 [SMILES: C=CCCC1CCC(c2ccc(-c3ccc(CCCOC(=O)C(=C)CO)cc3)cc2)CC1] |
| 1α-5-26 | 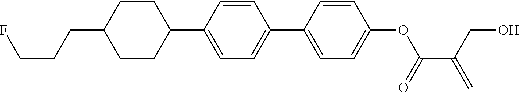 [SMILES: C=C(CO)C(=O)Oc1ccc(-c2ccc(C3CCC(CCCF)CC3)cc2)cc1] |
| 1α-5-27 | 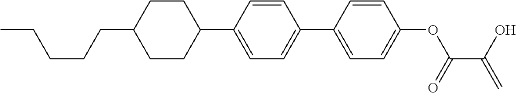 [SMILES: C=C(O)C(=O)Oc1ccc(-c2ccc(C3CCC(CCCCC)CC3)cc2)cc1] |
| 1α-5-28 | 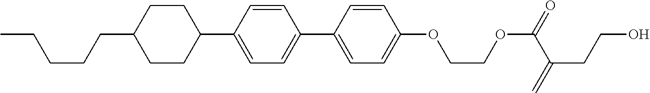 [SMILES: C=C(CCO)C(=O)OCCOc1ccc(-c2ccc(C3CCC(CCCCC)CC3)cc2)cc1] |
| 1α-5-29 | 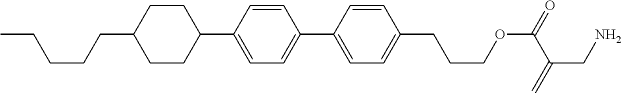 [SMILES: C=C(CN)C(=O)OCCCc1ccc(-c2ccc(C3CCC(CCCCC)CC3)cc2)cc1] |
| 1α-5-30 | 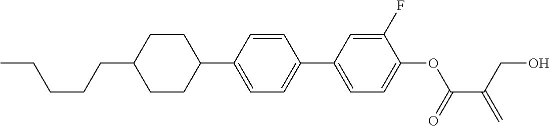 [SMILES: C=C(CO)C(=O)Oc1ccc(-c2ccc(C3CCC(CCCCC)CC3)cc2)cc1F] |
| 1α-5-31 | 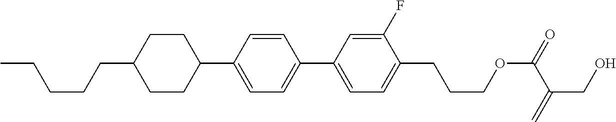 [SMILES: C=C(CO)C(=O)OCCCc1ccc(-c2ccc(C3CCC(CCCCC)CC3)cc2)cc1F] |
| 1α-5-32 | 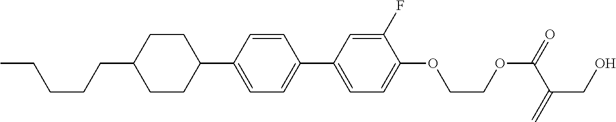 [SMILES: C=C(CO)C(=O)OCCOc1ccc(-c2ccc(C3CCC(CCCCC)CC3)cc2)cc1F] |
| 1α-5-33 | 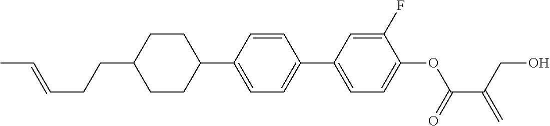 [SMILES: C=C(CO)C(=O)Oc1ccc(-c2ccc(C3CCC(CC/C=C/C)CC3)cc2)cc1F] |
| 1α-5-34 | 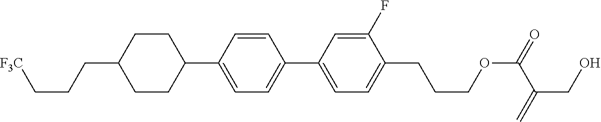 [SMILES: C=C(CO)C(=O)OCCCc1ccc(-c2ccc(C3CCC(CCCC(F)(F)F)CC3)cc2)cc1F] |
| 1α-5-35 | 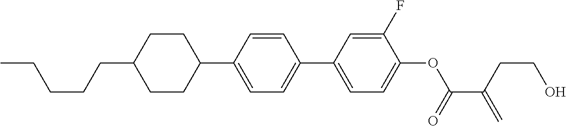 [SMILES: C=C(CCO)C(=O)Oc1ccc(-c2ccc(C3CCC(CCCCC)CC3)cc2)cc1F] |
| 1α-5-36 | 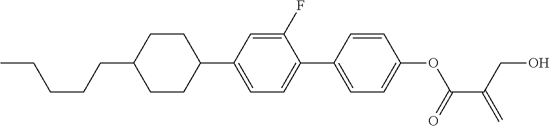 [SMILES: C=C(CO)C(=O)Oc1ccc(-c2ccc(C3CCC(CCCCC)CC3)cc2F)cc1] |
| 1α-5-37 | 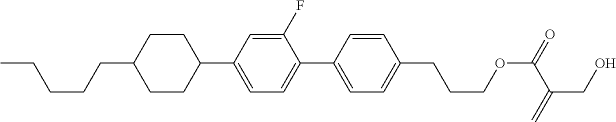 [SMILES: C=C(CO)C(=O)OCCCc1ccc(-c2ccc(C3CCC(CCCCC)CC3)cc2F)cc1] |
| 1α-5-38 | 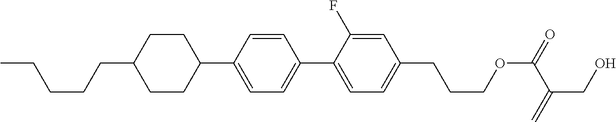 [SMILES: C=C(CO)C(=O)OCCCc1ccc(-c2ccc(C3CCC(CCCCC)CC3)cc2)c(F)c1] |
| 1α-5-39 | 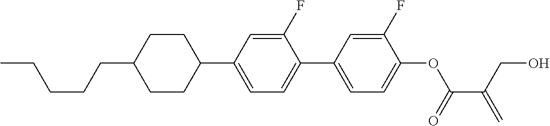 [SMILES: C=C(CO)C(=O)Oc1ccc(-c2ccc(C3CCC(CCCCC)CC3)cc2F)cc1F] |
| 1α-5-40 | 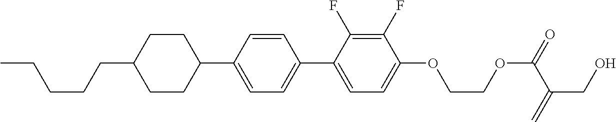 [SMILES: C=C(CO)C(=O)OCCOc1ccc(-c2ccc(C3CCC(CCCCC)CC3)cc2)c(F)c1F] |
| 1α-5-41 | 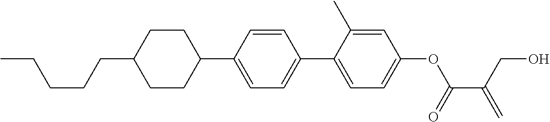 [SMILES: C=C(CO)C(=O)Oc1ccc(-c2ccc(C3CCC(CCCCC)CC3)cc2)c(C)c1] |
| 1α-5-42 | 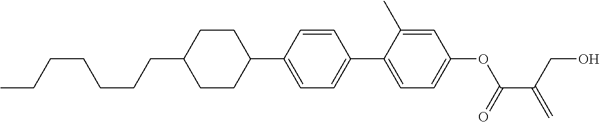 [SMILES: C=C(CO)C(=O)Oc1ccc(-c2ccc(C3CCC(CCCCCCC)CC3)cc2)c(C)c1] |
| 1α-5-43 | 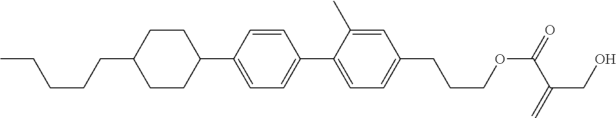 [SMILES: C=C(CO)C(=O)OCCCc1ccc(-c2ccc(C3CCC(CCCCC)CC3)cc2)c(C)c1] |
| 1α-5-44 | 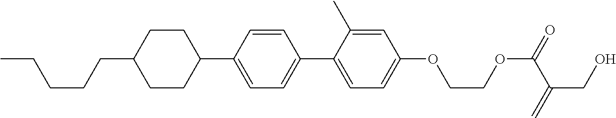 [SMILES: C=C(CO)C(=O)OCCOc1ccc(-c2ccc(C3CCC(CCCCC)CC3)cc2)c(C)c1] |
| 1α-5-45 | 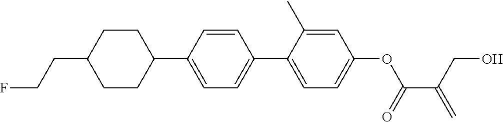 [SMILES: C=C(CO)C(=O)Oc1ccc(-c2ccc(C3CCC(CCF)CC3)cc2)c(C)c1] |
| 1α-5-46 | 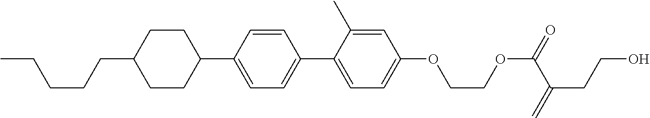 [SMILES: C=C(CCO)C(=O)OCCOc1ccc(-c2ccc(C3CCC(CCCCC)CC3)cc2)c(C)c1] |
| 1α-5-47 | 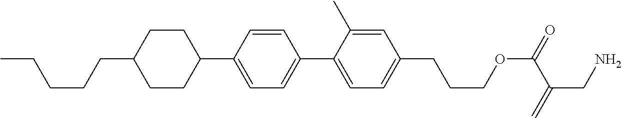 [SMILES: C=C(CN)C(=O)OCCCc1ccc(-c2ccc(C3CCC(CCCCC)CC3)cc2)c(C)c1] |
| 1α-5-48 | 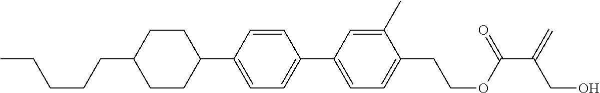 [SMILES: C=C(CO)C(=O)OCCc1ccc(-c2ccc(C3CCC(CCCCC)CC3)cc2)cc1C] |
| 1α-5-49 | 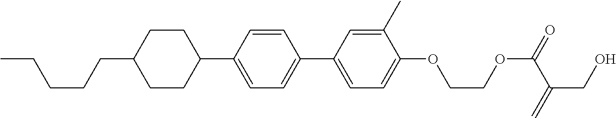 [SMILES: C=C(CO)C(=O)OCCOc1ccc(-c2ccc(C3CCC(CCCCC)CC3)cc2)cc1C] |
| 1α-5-50 | 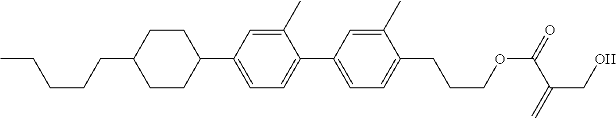 [SMILES: C=C(CO)C(=O)OCCCc1ccc(-c2ccc(C3CCC(CCCCC)CC3)cc2C)cc1C] |
| 1α-5-51 | 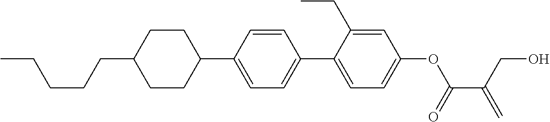 [SMILES: C=C(CO)C(=O)Oc1ccc(-c2ccc(C3CCC(CCCCC)CC3)cc2)c(CC)c1] |
| 1α-5-52 | 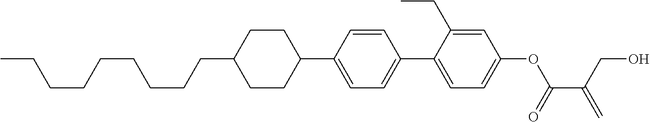 [SMILES: C=C(CO)C(=O)Oc1ccc(-c2ccc(C3CCC(CCCCCCCCC)CC3)cc2)c(CC)c1] |
| 1α-5-53 | 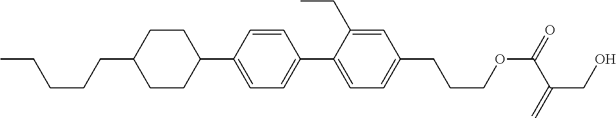 [SMILES: C=C(CO)C(=O)OCCCc1ccc(-c2ccc(C3CCC(CCCCC)CC3)cc2)c(CC)c1] |
| 1α-5-54 | 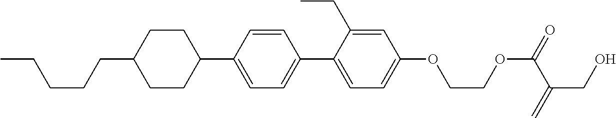 [SMILES: C=C(CO)C(=O)OCCOc1ccc(-c2ccc(C3CCC(CCCCC)CC3)cc2)c(CC)c1] |
| 1α-5-55 | 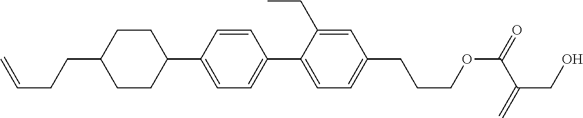 [SMILES: C=CCCC1CCC(c2ccc(-c3ccc(CCCOC(=O)C(=C)CO)cc3CC)cc2)CC1] |
| 1α-5-56 | 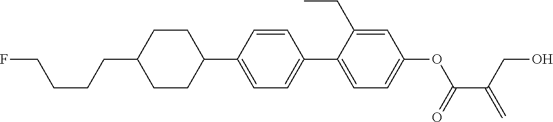 [SMILES: C=C(CO)C(=O)Oc1ccc(-c2ccc(C3CCC(CCCCF)CC3)cc2)c(CC)c1] |
| 1α-5-57 | 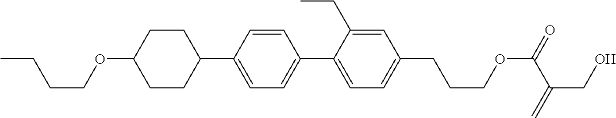 [SMILES: C=C(CO)C(=O)OCCCc1ccc(-c2ccc(C3CCC(OCCCC)CC3)cc2)c(CC)c1] |
| 1α-5-58 | 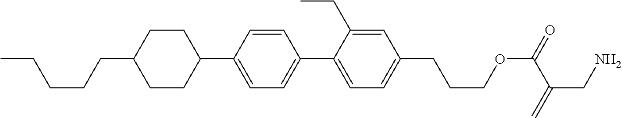 [SMILES: C=C(CN)C(=O)OCCCc1ccc(-c2ccc(C3CCC(CCCCC)CC3)cc2)c(CC)c1] |
| 1α-5-59 | 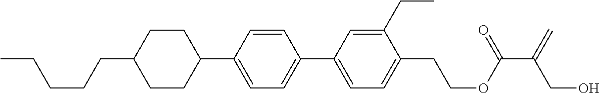 [SMILES: C=C(CO)C(=O)OCCc1ccc(-c2ccc(C3CCC(CCCCC)CC3)cc2)cc1CC] |
| 1α-5-60 | 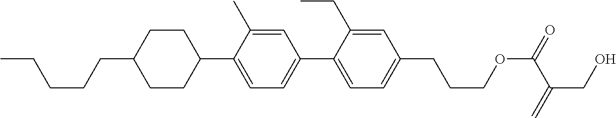 [SMILES: C=C(CO)C(=O)OCCCc1ccc(-c2ccc(C3CCC(CCCCC)CC3)c(C)c2)c(CC)c1] |
| 1α-5-61 | 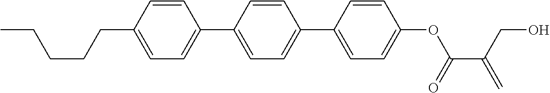 [SMILES: C=C(CO)C(=O)Oc1ccc(-c2ccc(-c3ccc(CCCCC)cc3)cc2)cc1] |
| 1α-5-62 | 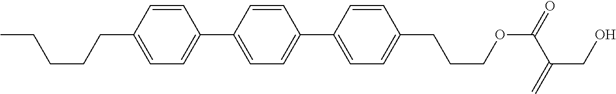 [SMILES: C=C(CO)C(=O)OCCCc1ccc(-c2ccc(-c3ccc(CCCCC)cc3)cc2)cc1] |
| 1α-5-63 | 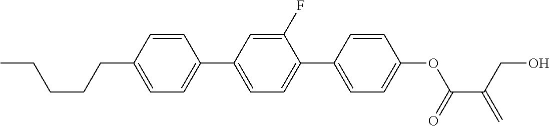 [SMILES: C=C(CO)C(=O)Oc1ccc(-c2ccc(-c3ccc(CCCCC)cc3)cc2F)cc1] |
| 1α-5-64 | 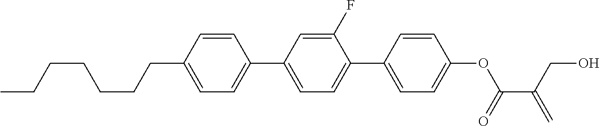 [SMILES: C=C(CO)C(=O)Oc1ccc(-c2ccc(-c3ccc(CCCCCCC)cc3)cc2F)cc1] |
| 1α-5-65 | 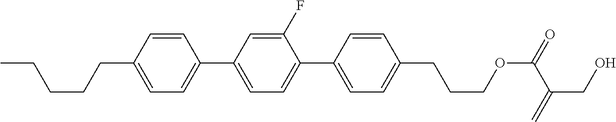 [SMILES: C=C(CO)C(=O)OCCCc1ccc(-c2ccc(-c3ccc(CCCCC)cc3)cc2F)cc1] |
| 1α-5-66 | 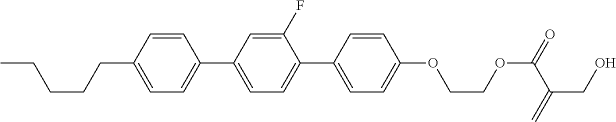 [SMILES: C=C(CO)C(=O)OCCOc1ccc(-c2ccc(-c3ccc(CCCCC)cc3)cc2F)cc1] |
| 1α-5-67 | 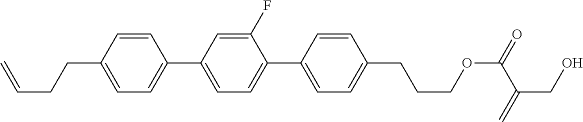 [SMILES: C=CCCc1ccc(-c2ccc(-c3ccc(CCCOC(=O)C(=C)CO)cc3)c(F)c2)cc1] |
| 1α-5-68 | 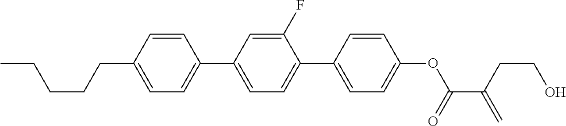 [SMILES: C=C(CCO)C(=O)Oc1ccc(-c2ccc(-c3ccc(CCCCC)cc3)cc2F)cc1] |
| 1α-5-69 | 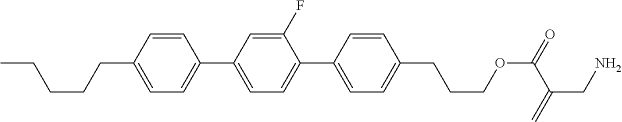 [SMILES: C=C(CN)C(=O)OCCCc1ccc(-c2ccc(-c3ccc(CCCCC)cc3)cc2F)cc1] |
| 1α-5-70 | 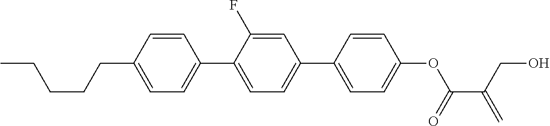 [SMILES: C=C(CO)C(=O)Oc1ccc(-c2ccc(-c3ccc(CCCCC)cc3)c(F)c2)cc1] |
| 1α-5-71 | 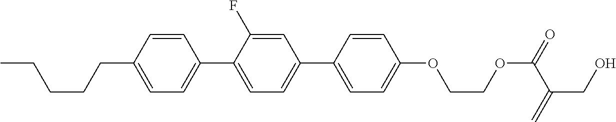 [SMILES: C=C(CO)C(=O)OCCOc1ccc(-c2ccc(-c3ccc(CCCCC)cc3)c(F)c2)cc1] |
| 1α-5-72 | 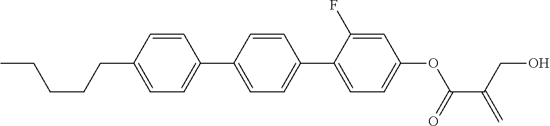 [SMILES: C=C(CO)C(=O)Oc1ccc(-c2ccc(-c3ccc(CCCCC)cc3)cc2)c(F)c1] |
| 1α-5-73 | 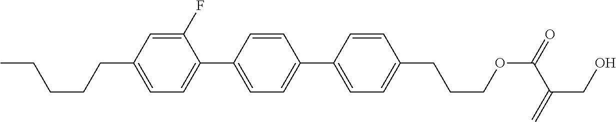 [SMILES: C=C(CO)C(=O)OCCCc1ccc(-c2ccc(-c3ccc(CCCCC)cc3F)cc2)cc1] |
| 1α-5-74 | 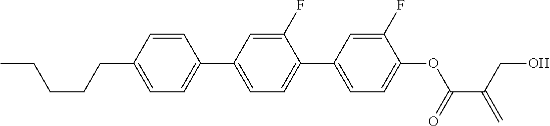 [SMILES: C=C(CO)C(=O)Oc1ccc(-c2ccc(-c3ccc(CCCCC)cc3)cc2F)cc1F] |
| 1α-5-75 | 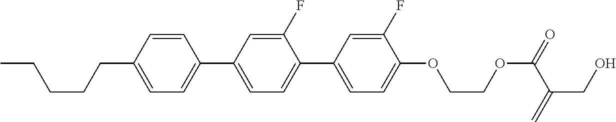 [SMILES: C=C(CO)C(=O)OCCOc1ccc(-c2ccc(-c3ccc(CCCCC)cc3)cc2F)cc1F] |
| 1α-5-76 | 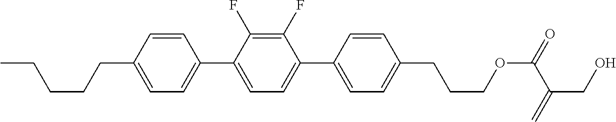 [SMILES: C=C(CO)C(=O)OCCCc1ccc(-c2ccc(-c3ccc(CCCCC)cc3)c(F)c2F)cc1] |
| 1α-5-77 | 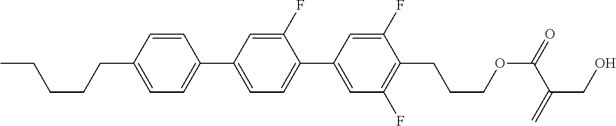 [SMILES: C=C(CO)C(=O)OCCCc1c(F)cc(-c2ccc(-c3ccc(CCCCC)cc3)cc2F)cc1F] |
| 1α-5-78 | 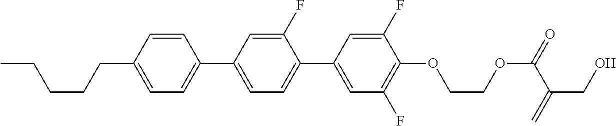 [SMILES: C=C(CO)C(=O)OCCOc1c(F)cc(-c2ccc(-c3ccc(CCCCC)cc3)cc2F)cc1F] |
| 1α-5-79 | 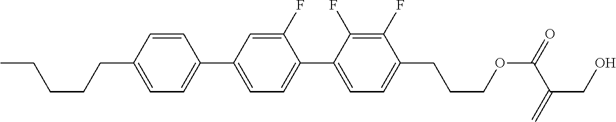 [SMILES: C=C(CO)C(=O)OCCCc1ccc(-c2ccc(-c3ccc(CCCCC)cc3)cc2F)c(F)c1F] |
| 1α-5-80 | 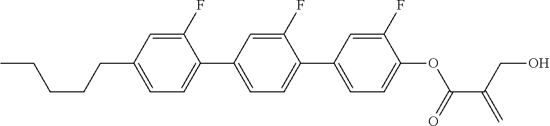 [SMILES: C=C(CO)C(=O)Oc1ccc(-c2ccc(-c3ccc(CCCCC)cc3F)cc2F)cc1F] |
| 1α-5-81 | 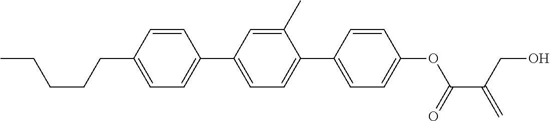 [SMILES: C=C(CO)C(=O)Oc1ccc(-c2ccc(-c3ccc(CCCCC)cc3)cc2C)cc1] |
| 1α-5-82 | 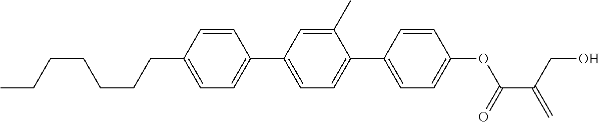 [SMILES: C=C(CO)C(=O)Oc1ccc(-c2ccc(-c3ccc(CCCCCCC)cc3)cc2C)cc1] |
| 1α-5-83 | 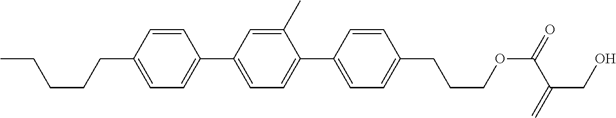 [SMILES: C=C(CO)C(=O)OCCCc1ccc(-c2ccc(-c3ccc(CCCCC)cc3)cc2C)cc1] |
| 1α-5-84 | 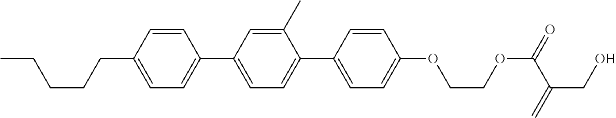 [SMILES: C=C(CO)C(=O)OCCOc1ccc(-c2ccc(-c3ccc(CCCCC)cc3)cc2C)cc1] |
| 1α-5-85 | 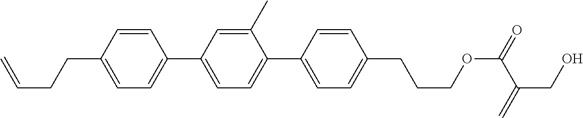 [SMILES: C=CCCc1ccc(-c2ccc(-c3ccc(CCCOC(=O)C(=C)CO)cc3)c(C)c2)cc1] |
| 1α-5-86 | 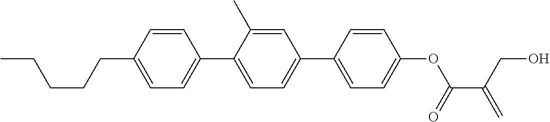 [SMILES: C=C(CO)C(=O)Oc1ccc(-c2ccc(-c3ccc(CCCCC)cc3)c(C)c2)cc1] |
| 1α-5-87 | 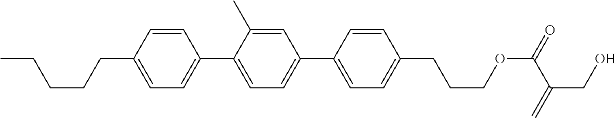 [SMILES: C=C(CO)C(=O)OCCCc1ccc(-c2ccc(-c3ccc(CCCCC)cc3)c(C)c2)cc1] |
| 1α-5-88 | 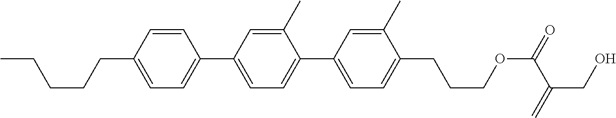 [SMILES: C=C(CO)C(=O)OCCCc1ccc(-c2ccc(-c3ccc(CCCCC)cc3)cc2C)cc1C] |
| 1α-5-89 | 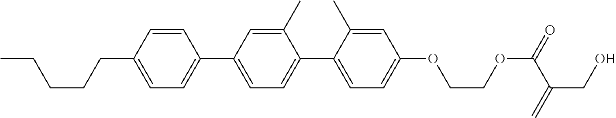 [SMILES: C=C(CO)C(=O)OCCOc1ccc(-c2ccc(-c3ccc(CCCCC)cc3)cc2C)c(C)c1] |
| 1α-5-90 | 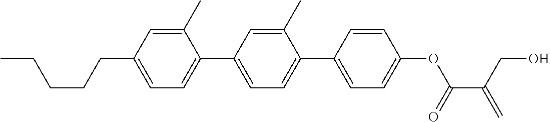 [SMILES: C=C(CO)C(=O)Oc1ccc(-c2ccc(-c3ccc(CCCCC)cc3C)cc2C)cc1] |
| 1α-5-91 | 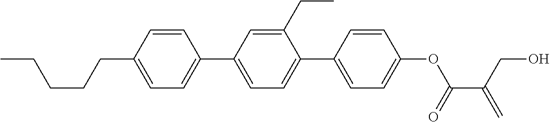 [SMILES: C=C(CO)C(=O)Oc1ccc(-c2ccc(-c3ccc(CCCCC)cc3)cc2CC)cc1] |
| 1α-5-92 | 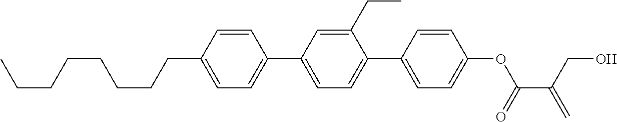 [SMILES: C=C(CO)C(=O)Oc1ccc(-c2ccc(-c3ccc(CCCCCCCC)cc3)cc2CC)cc1] |
| 1α-5-93 | 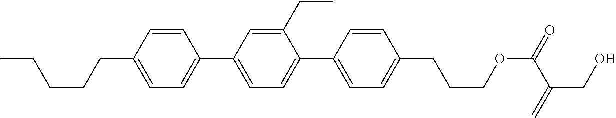 [SMILES: C=C(CO)C(=O)OCCCc1ccc(-c2ccc(-c3ccc(CCCCC)cc3)cc2CC)cc1] |
| 1α-5-94 | 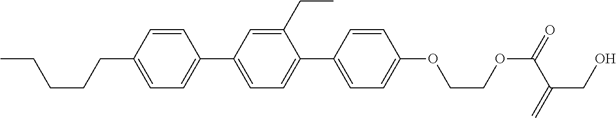 [SMILES: C=C(CO)C(=O)OCCOc1ccc(-c2ccc(-c3ccc(CCCCC)cc3)cc2CC)cc1] |
| 1α-5-95 | 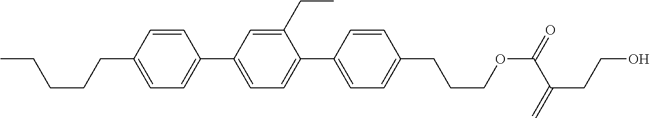 [SMILES: C=C(CCO)C(=O)OCCCc1ccc(-c2ccc(-c3ccc(CCCCC)cc3)cc2CC)cc1] |
| 1α-5-96 | 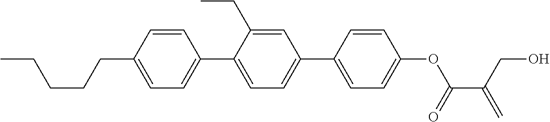 [SMILES: C=C(CO)C(=O)Oc1ccc(-c2ccc(-c3ccc(CCCCC)cc3)c(CC)c2)cc1] |
| 1α-5-97 | 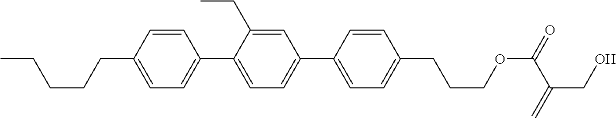 [SMILES: C=C(CO)C(=O)OCCCc1ccc(-c2ccc(-c3ccc(CCCCC)cc3)c(CC)c2)cc1] |
| 1α-5-98 | 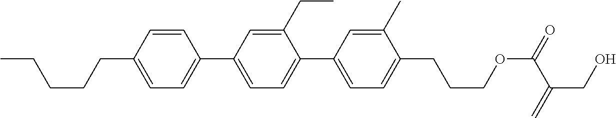 [SMILES: C=C(CO)C(=O)OCCCc1ccc(-c2ccc(-c3ccc(CCCCC)cc3)cc2CC)cc1C] |
| 1α-5-99 | 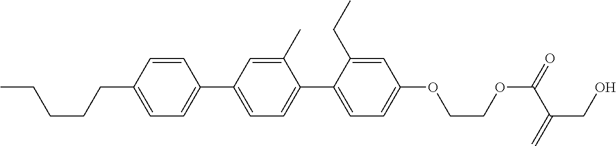 [SMILES: C=C(CO)C(=O)OCCOc1ccc(-c2ccc(-c3ccc(CCCCC)cc3)cc2C)c(CC)c1] |
| 1α-5-100 | 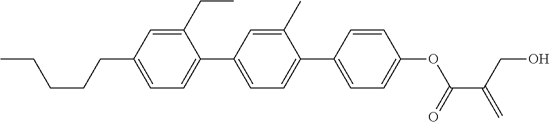 [SMILES: C=C(CO)C(=O)Oc1ccc(-c2ccc(-c3ccc(CCCCC)cc3CC)cc2C)cc1] |
| 1α-5-101 | 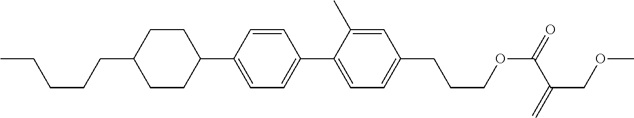 [SMILES: C=C(COC)C(=O)OCCCc1ccc(-c2ccc(C3CCC(CCCCC)CC3)cc2)c(C)c1] |
| 1α-5-102 | 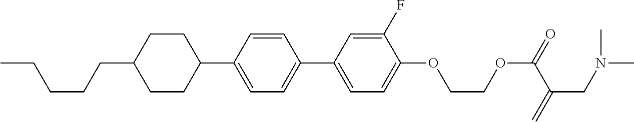 [SMILES: C=C(CN(C)C)C(=O)OCCOc1ccc(-c2ccc(C3CCC(CCCCC)CC3)cc2)cc1F] |
| 1α-5-103 | 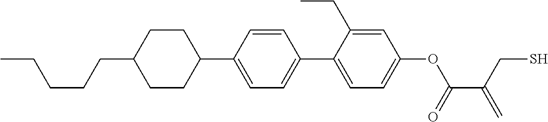 [SMILES: C=C(CS)C(=O)Oc1ccc(-c2ccc(C3CCC(CCCCC)CC3)cc2)c(CC)c1] |
| 1α-5-104 | 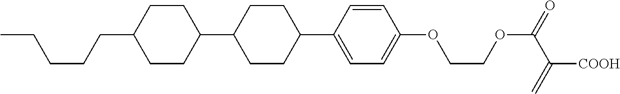 [SMILES: C=C(C(=O)O)C(=O)OCCOc1ccc(C2CCC(C3CCC(CCCCC)CC3)CC2)cc1] |
| 1α-5-105 | 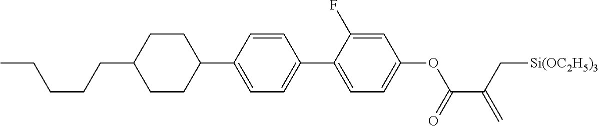 |
| 1α-5-106 | 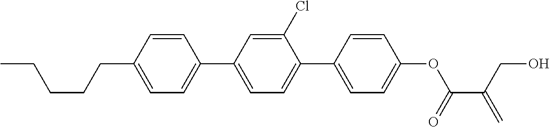 [SMILES: C=C(CO)C(=O)Oc1ccc(-c2ccc(-c3ccc(CCCCC)cc3)cc2Cl)cc1] |
| 1α-5-107 | 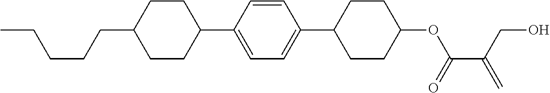 [SMILES: C=C(CO)C(=O)OC1CCC(c2ccc(C3CCC(CCCCC)CC3)cc2)CC1] |
| 1α-5-108 | 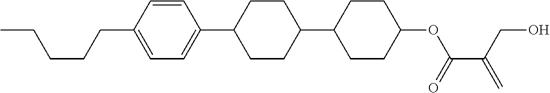 [SMILES: C=C(CO)C(=O)OC1CCC(C2CCC(c3ccc(CCCCC)cc3)CC2)CC1] |
| 1α-5-109 | 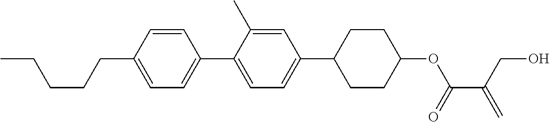 [SMILES: C=C(CO)C(=O)OC1CCC(c2ccc(-c3ccc(CCCCC)cc3)c(C)c2)CC1] |
| 1α-5-110 | 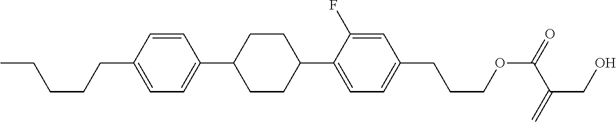 [SMILES: C=C(CO)C(=O)OCCCc1ccc(C2CCC(c3ccc(CCCCC)cc3)CC2)c(F)c1] |
| 1α-5-111 | 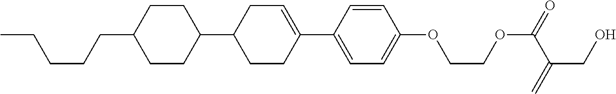 [SMILES: C=C(CO)C(=O)OCCOc1ccc(C2=CCC(C3CCC(CCCCC)CC3)CC2)cc1] |
| 1α-5-112 | 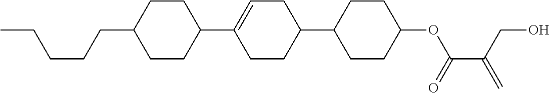 [SMILES: C=C(CO)C(=O)OC1CCC(C2CC=C(C3CCC(CCCCC)CC3)CC2)CC1] |
| 1α-5-113 | 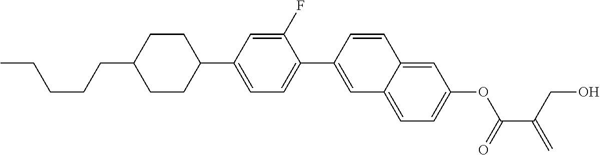 [SMILES: C=C(CO)C(=O)Oc1ccc2cc(-c3ccc(C4CCC(CCCCC)CC4)cc3F)ccc2c1] |
| 1α-5-114 | 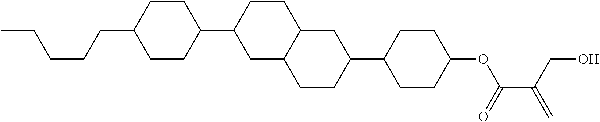 [SMILES: C=C(CO)C(=O)OC1CCC(C2CCC3CC(C4CCC(CCCCC)CC4)CCC3C2)CC1] |
| 1α-5-115 | 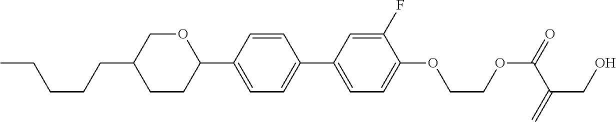 [SMILES: C=C(CO)C(=O)OCCOc1ccc(-c2ccc(C3CCC(CCCCC)CO3)cc2)cc1F] |
| 1α-5-116 | 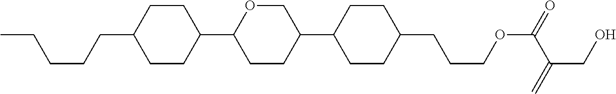 [SMILES: C=C(CO)C(=O)OCCCC1CCC(C2CCC(C3CCC(CCCCC)CC3)OC2)CC1] |
| 1α-5-117 | 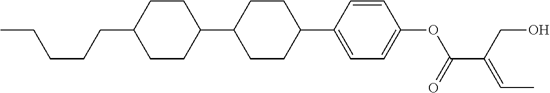 [SMILES: C/C=C(\CO)C(=O)Oc1ccc(C2CCC(C3CCC(CCCCC)CC3)CC2)cc1] |
| 1α-5-118 | 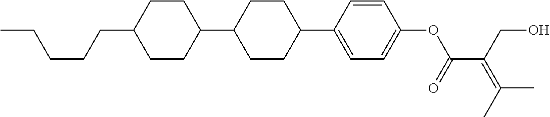 [SMILES: CCCCCC1CCC(C2CCC(c3ccc(OC(=O)C(CO)=C(C)C)cc3)CC2)CC1] |
| 1α-5-119 | 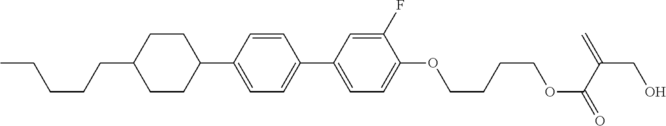 [SMILES: C=C(CO)C(=O)OCCCCOc1ccc(-c2ccc(C3CCC(CCCCC)CC3)cc2)cc1F] |
| 1α-5-120 | 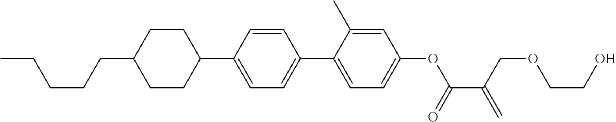 [SMILES: C=C(COCCO)C(=O)Oc1ccc(-c2ccc(C3CCC(CCCCC)CC3)cc2)c(C)c1] |
| 1α-5-121 | 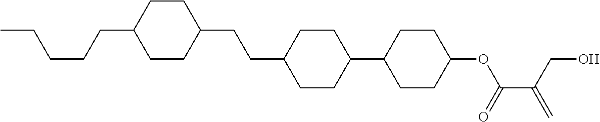 [SMILES: C=C(CO)C(=O)OC1CCC(C2CCC(CCC3CCC(CCCCC)CC3)CC2)CC1] |
| 1α-5-122 | 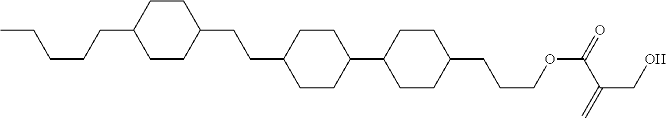 [SMILES: C=C(CO)C(=O)OCCCC1CCC(C2CCC(CCC3CCC(CCCCC)CC3)CC2)CC1] |
| 1α-5-123 | 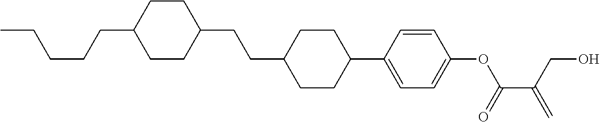 [SMILES: C=C(CO)C(=O)Oc1ccc(C2CCC(CCC3CCC(CCCCC)CC3)CC2)cc1] |
| 1α-5-124 | 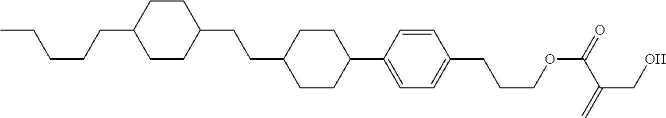 [SMILES: C=C(CO)C(=O)OCCCc1ccc(C2CCC(CCC3CCC(CCCCC)CC3)CC2)cc1] |
| 1α-5-125 | 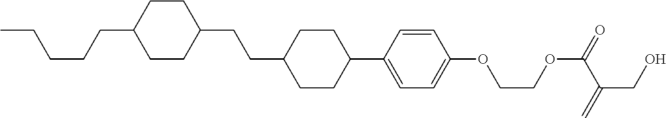 [SMILES: C=C(CO)C(=O)OCCOc1ccc(C2CCC(CCC3CCC(CCCCC)CC3)CC2)cc1] |
| 1α-5-126 | 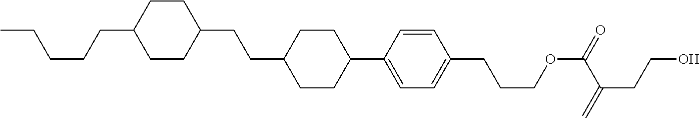 [SMILES: C=C(CCO)C(=O)OCCCc1ccc(C2CCC(CCC3CCC(CCCCC)CC3)CC2)cc1] |
| 1α-5-127 | 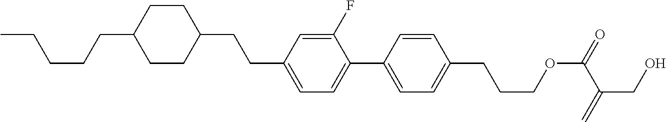 [SMILES: C=C(CO)C(=O)OCCCc1ccc(-c2ccc(CCC3CCC(CCCCC)CC3)cc2F)cc1] |
| 1α-5-128 | 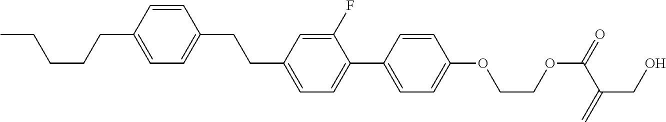 [SMILES: C=C(CO)C(=O)OCCOc1ccc(-c2ccc(CCc3ccc(CCCCC)cc3)cc2F)cc1] |
| 1α-5-129 | 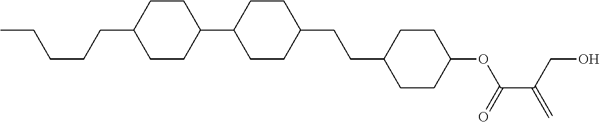 [SMILES: C=C(CO)C(=O)OC1CCC(CCC2CCC(C3CCC(CCCCC)CC3)CC2)CC1] |
| 1α-5-130 | 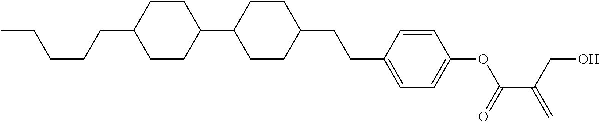 [SMILES: C=C(CO)C(=O)Oc1ccc(CCC2CCC(C3CCC(CCCCC)CC3)CC2)cc1] |
| 1α-5-131 | 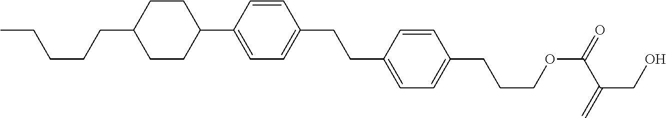 [SMILES: C=C(CO)C(=O)OCCCc1ccc(CCc2ccc(C3CCC(CCCCC)CC3)cc2)cc1] |
| 1α-5-132 | 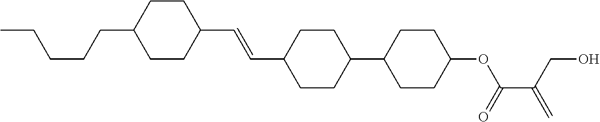 [SMILES: C=C(CO)C(=O)OC1CCC(C2CCC(/C=C/C3CCC(CCCCC)CC3)CC2)CC1] |
| 1α-5-133 | 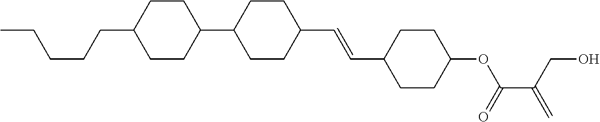 [SMILES: C=C(CO)C(=O)OC1CCC(/C=C/C2CCC(C3CCC(CCCCC)CC3)CC2)CC1] |
| 1α-5-134 | 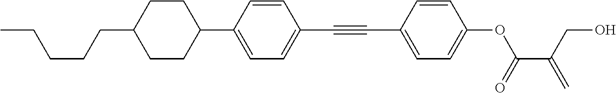 [SMILES: C=C(CO)C(=O)Oc1ccc(C#Cc2ccc(C3CCC(CCCCC)CC3)cc2)cc1] |
| 1α-5-135 | 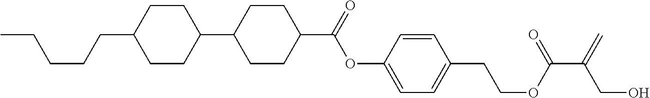 [SMILES: C=C(CO)C(=O)OCCc1ccc(OC(=O)C2CCC(C3CCC(CCCCC)CC3)CC2)cc1] |
| 1α-5-136 | 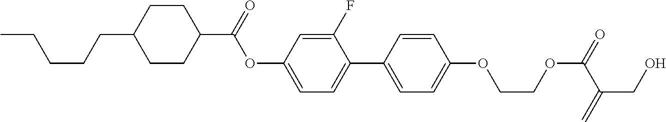 [SMILES: C=C(CO)C(=O)OCCOc1ccc(-c2ccc(OC(=O)C3CCC(CCCCC)CC3)cc2F)cc1] |
| 1α-5-137 | 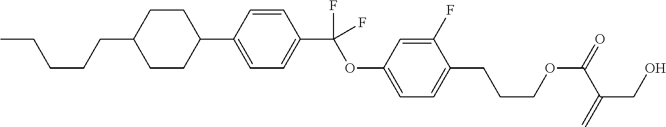 [SMILES: C=C(CO)C(=O)OCCCc1ccc(OC(F)(F)c2ccc(C3CCC(CCCCC)CC3)cc2)cc1F] |
| 1α-5-138 | 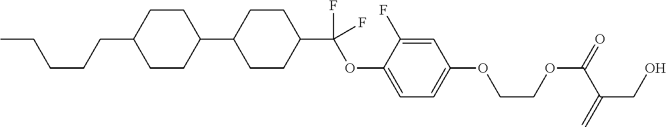 [SMILES: C=C(CO)C(=O)OCCOc1ccc(OC(F)(F)C2CCC(C3CCC(CCCCC)CC3)CC2)c(F)c1] |
| 1α-5-139 | 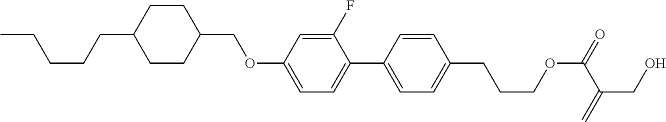 [SMILES: C=C(CO)C(=O)OCCCc1ccc(-c2ccc(OCC3CCC(CCCCC)CC3)cc2F)cc1] |
| 1α-5-140 | 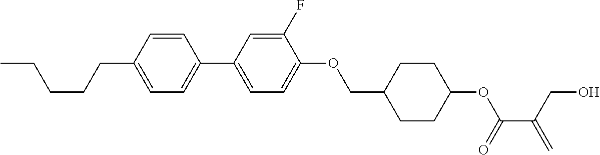 [SMILES: C=C(CO)C(=O)OC1CCC(COc2ccc(-c3ccc(CCCCC)cc3)cc2F)CC1] |
| 1α-6-1 | 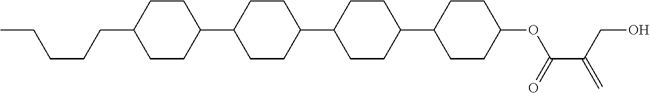 [SMILES: C=C(CO)C(=O)OC1CCC(C2CCC(C3CCC(C4CCC(CCCCC)CC4)CC3)CC2)CC1] |
| 1α-6-2 | 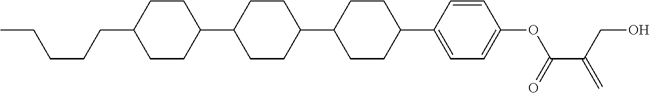 [SMILES: C=C(CO)C(=O)Oc1ccc(C2CCC(C3CCC(C4CCC(CCCCC)CC4)CC3)CC2)cc1] |
| 1α-6-3 | 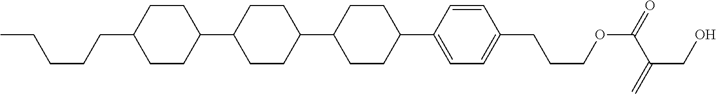 [SMILES: C=C(CO)C(=O)OCCCc1ccc(C2CCC(C3CCC(C4CCC(CCCCC)CC4)CC3)CC2)cc1] |
| 1α-6-4 | 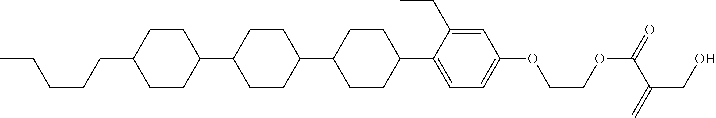 [SMILES: C=C(CO)C(=O)OCCOc1ccc(C2CCC(C3CCC(C4CCC(CCCCC)CC4)CC3)CC2)c(CC)c1] |
| 1α-6-5 | 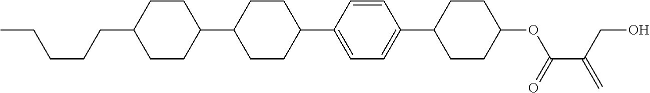 [SMILES: C=C(CO)C(=O)OC1CCC(c2ccc(C3CCC(C4CCC(CCCCC)CC4)CC3)cc2)CC1] |
| 1α-6-6 | 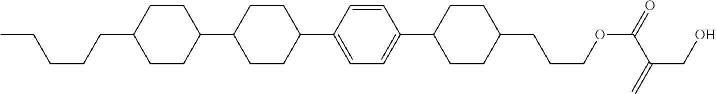 [SMILES: C=C(CO)C(=O)OCCCC1CCC(c2ccc(C3CCC(C4CCC(CCCCC)CC4)CC3)cc2)CC1] |
| 1α-6-7 | 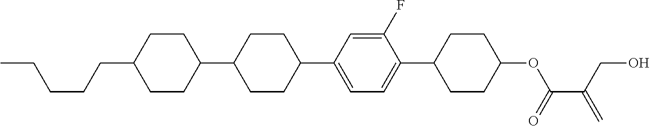 [SMILES: C=C(CO)C(=O)OC1CCC(c2ccc(C3CCC(C4CCC(CCCCC)CC4)CC3)cc2F)CC1] |
| 1α-6-8 | 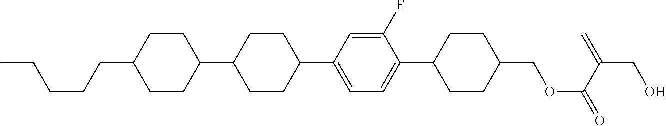 [SMILES: C=C(CO)C(=O)OCC1CCC(c2ccc(C3CCC(C4CCC(CCCCC)CC4)CC3)cc2F)CC1] |
| 1α-6-9 | 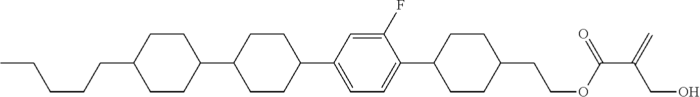 [SMILES: C=C(CO)C(=O)OCCC1CCC(c2ccc(C3CCC(C4CCC(CCCCC)CC4)CC3)cc2F)CC1] |
| 1α-6-10 | 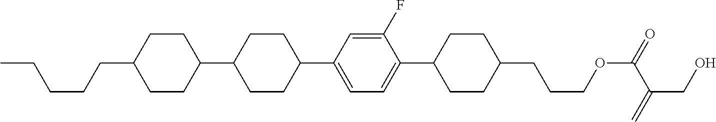 [SMILES: C=C(CO)C(=O)OCCCC1CCC(c2ccc(C3CCC(C4CCC(CCCCC)CC4)CC3)cc2F)CC1] |
| 1α-6-11 | 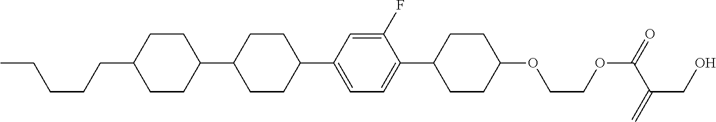 [SMILES: C=C(CO)C(=O)OCCOC1CCC(c2ccc(C3CCC(C4CCC(CCCCC)CC4)CC3)cc2F)CC1] |
| 1α-6-12 | 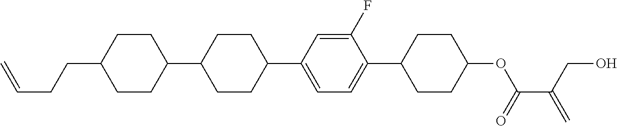 [SMILES: C=CCCC1CCC(C2CCC(c3ccc(C4CCC(OC(=O)C(=C)CO)CC4)c(F)c3)CC2)CC1] |
| 1α-6-13 | 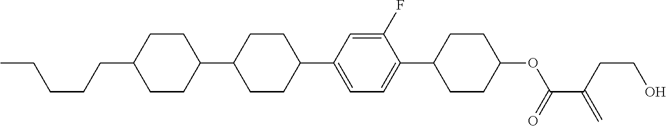 [SMILES: C=C(CCO)C(=O)OC1CCC(c2ccc(C3CCC(C4CCC(CCCCC)CC4)CC3)cc2F)CC1] |
| 1α-6-14 | 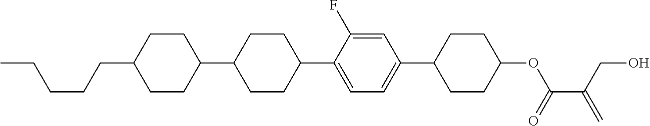 [SMILES: C=C(CO)C(=O)OC1CCC(c2ccc(C3CCC(C4CCC(CCCCC)CC4)CC3)c(F)c2)CC1] |
| 1α-6-15 | 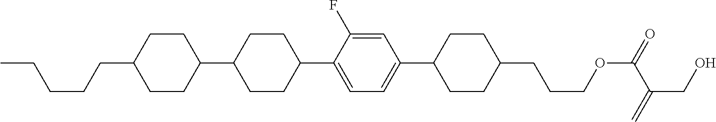 [SMILES: C=C(CO)C(=O)OCCCC1CCC(c2ccc(C3CCC(C4CCC(CCCCC)CC4)CC3)c(F)c2)CC1] |
| 1α-6-16 | 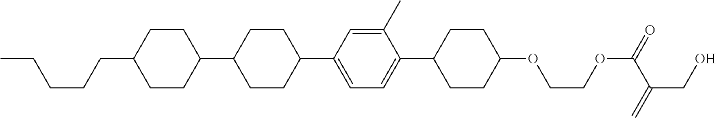 [SMILES: C=C(CO)C(=O)OCCOC1CCC(c2ccc(C3CCC(C4CCC(CCCCC)CC4)CC3)cc2C)CC1] |
| 1α-6-17 | 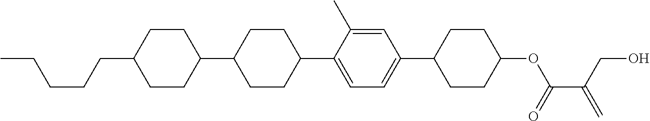 [SMILES: C=C(CO)C(=O)OC1CCC(c2ccc(C3CCC(C4CCC(CCCCC)CC4)CC3)c(C)c2)CC1] |
| 1α-6-18 | 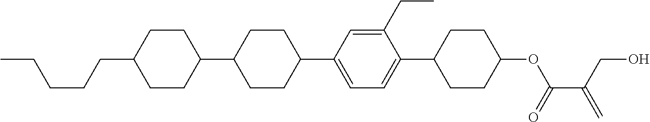 [SMILES: C=C(CO)C(=O)OC1CCC(c2ccc(C3CCC(C4CCC(CCCCC)CC4)CC3)cc2CC)CC1] |
| 1α-6-19 | 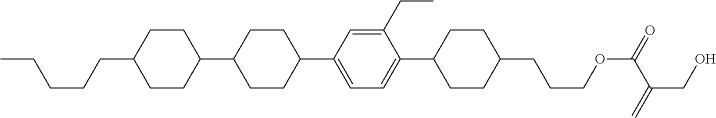 [SMILES: C=C(CO)C(=O)OCCCC1CCC(c2ccc(C3CCC(C4CCC(CCCCC)CC4)CC3)cc2CC)CC1] |
| 1α-6-20 | 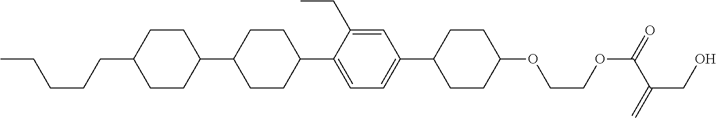 [SMILES: C=C(CO)C(=O)OCCOC1CCC(c2ccc(C3CCC(C4CCC(CCCCC)CC4)CC3)c(CC)c2)CC1] |
| 1α-6-21 | 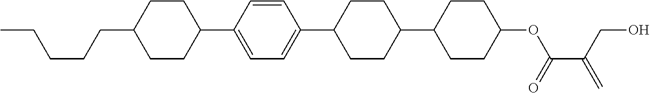 [SMILES: C=C(CO)C(=O)OC1CCC(C2CCC(c3ccc(C4CCC(CCCCC)CC4)cc3)CC2)CC1] |
| 1α-6-22 | 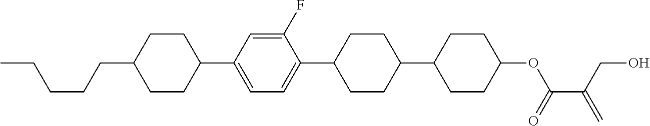 [SMILES: C=C(CO)C(=O)OC1CCC(C2CCC(c3ccc(C4CCC(CCCCC)CC4)cc3F)CC2)CC1] |
| 1α-6-23 | 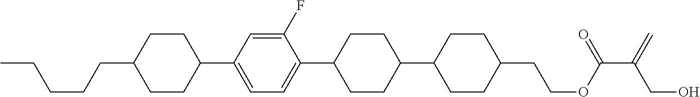 [SMILES: C=C(CO)C(=O)OCCC1CCC(C2CCC(c3ccc(C4CCC(CCCCC)CC4)cc3F)CC2)CC1] |
| 1α-6-24 | 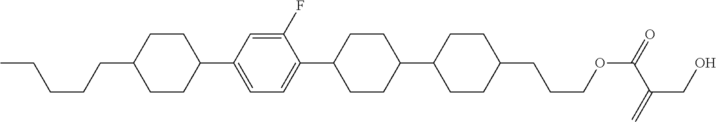 [SMILES: C=C(CO)C(=O)OCCCC1CCC(C2CCC(c3ccc(C4CCC(CCCCC)CC4)cc3F)CC2)CC1] |
| 1α-6-25 | 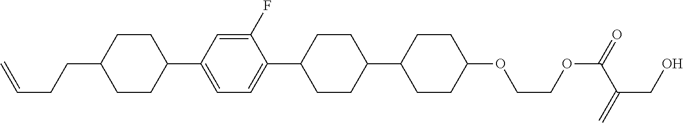 [SMILES: C=CCCC1CCC(c2ccc(C3CCC(C4CCC(OCCOC(=O)C(=C)CO)CC4)CC3)c(F)c2)CC1] |
| 1α-6-26 | 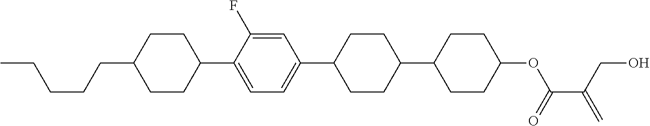 [SMILES: C=C(CO)C(=O)OC1CCC(C2CCC(c3ccc(C4CCC(CCCCC)CC4)c(F)c3)CC2)CC1] |
| 1α-6-27 | 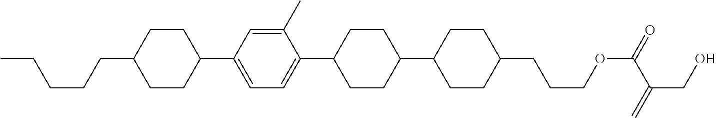 [SMILES: C=C(CO)C(=O)OCCCC1CCC(C2CCC(c3ccc(C4CCC(CCCCC)CC4)cc3C)CC2)CC1] |
| 1α-6-28 | 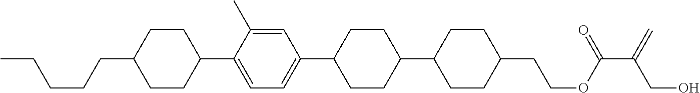 [SMILES: C=C(CO)C(=O)OCCC1CCC(C2CCC(c3ccc(C4CCC(CCCCC)CC4)c(C)c3)CC2)CC1] |
| 1α-6-29 | 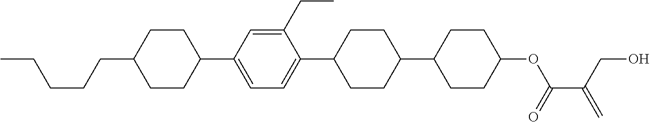 [SMILES: C=C(CO)C(=O)OC1CCC(C2CCC(c3ccc(C4CCC(CCCCC)CC4)cc3CC)CC2)CC1] |
| 1α-6-30 | 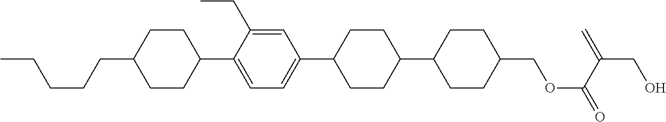 [SMILES: C=C(CO)C(=O)OCC1CCC(C2CCC(c3ccc(C4CCC(CCCCC)CC4)c(CC)c3)CC2)CC1] |
| 1α-6-31 | 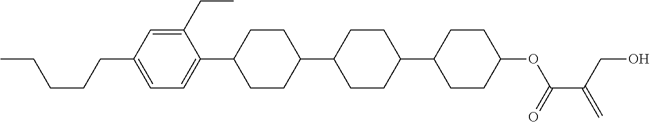 [SMILES: C=C(CO)C(=O)OC1CCC(C2CCC(C3CCC(c4ccc(CCCCC)cc4CC)CC3)CC2)CC1] |
| 1α-6-32 | 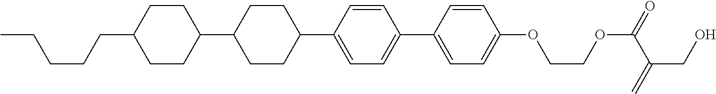 [SMILES: C=C(CO)C(=O)OCCOc1ccc(-c2ccc(C3CCC(C4CCC(CCCCC)CC4)CC3)cc2)cc1] |
| 1α-6-33 | 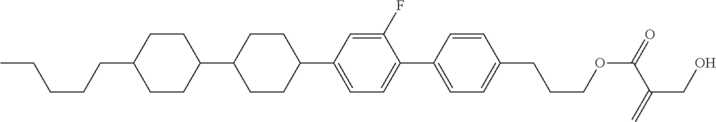 [SMILES: C=C(CO)C(=O)OCCCc1ccc(-c2ccc(C3CCC(C4CCC(CCCCC)CC4)CC3)cc2F)cc1] |
| 1α-6-34 | 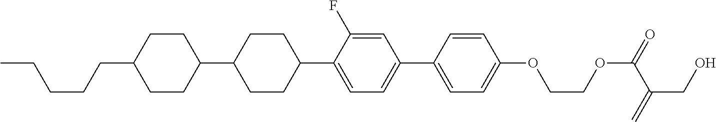 [SMILES: C=C(CO)C(=O)OCCOc1ccc(-c2ccc(C3CCC(C4CCC(CCCCC)CC4)CC3)c(F)c2)cc1] |
| 1α-6-35 | 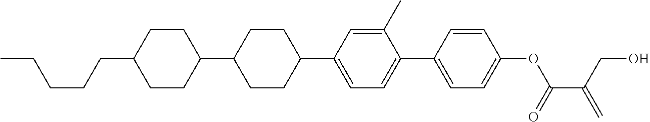 [SMILES: C=C(CO)C(=O)Oc1ccc(-c2ccc(C3CCC(C4CCC(CCCCC)CC4)CC3)cc2C)cc1] |
| 1α-6-36 | 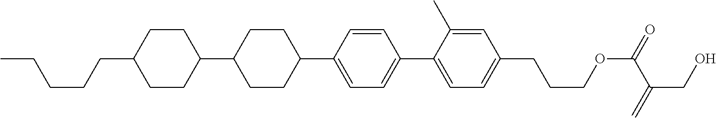 [SMILES: C=C(CO)C(=O)OCCCc1ccc(-c2ccc(C3CCC(C4CCC(CCCCC)CC4)CC3)cc2)c(C)c1] |
| 1α-6-37 | 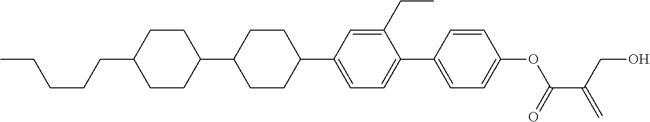 [SMILES: C=C(CO)C(=O)Oc1ccc(-c2ccc(C3CCC(C4CCC(CCCCC)CC4)CC3)cc2CC)cc1] |
| 1α-6-38 | 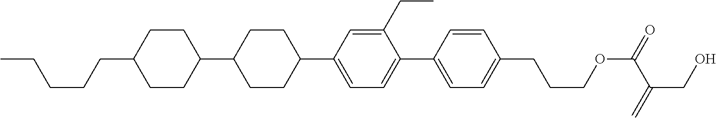 [SMILES: C=C(CO)C(=O)OCCCc1ccc(-c2ccc(C3CCC(C4CCC(CCCCC)CC4)CC3)cc2CC)cc1] |
| 1α-6-39 | 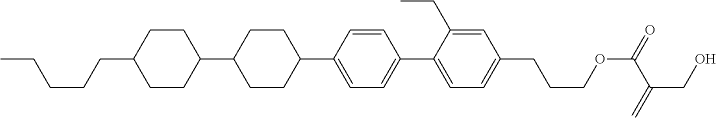 [SMILES: C=C(CO)C(=O)OCCCc1ccc(-c2ccc(C3CCC(C4CCC(CCCCC)CC4)CC3)cc2)c(CC)c1] |
| 1α-6-40 | 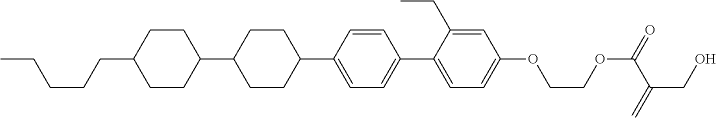 [SMILES: C=C(CO)C(=O)OCCOc1ccc(-c2ccc(C3CCC(C4CCC(CCCCC)CC4)CC3)cc2)c(CC)c1] |
| 1α-6-41 | 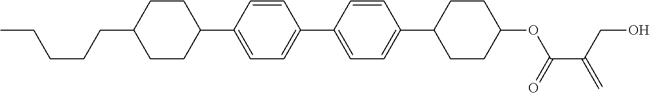 [SMILES: C=C(CO)C(=O)OC1CCC(c2ccc(-c3ccc(C4CCC(CCCCC)CC4)cc3)cc2)CC1] |
| 1α-6-42 | 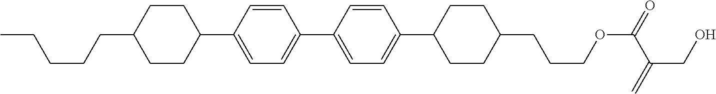 [SMILES: C=C(CO)C(=O)OCCCC1CCC(c2ccc(-c3ccc(C4CCC(CCCCC)CC4)cc3)cc2)CC1] |
| 1α-6-43 | 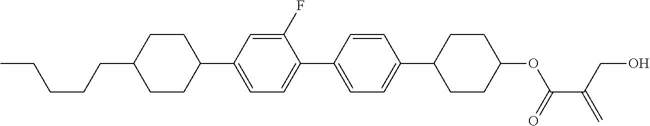 [SMILES: C=C(CO)C(=O)OC1CCC(c2ccc(-c3ccc(C4CCC(CCCCC)CC4)cc3F)cc2)CC1] |
| 1α-6-44 | 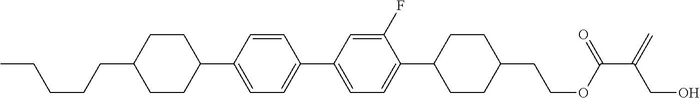 [SMILES: C=C(CO)C(=O)OCCC1CCC(c2ccc(-c3ccc(C4CCC(CCCCC)CC4)cc3)cc2F)CC1] |
| 1α-6-45 | 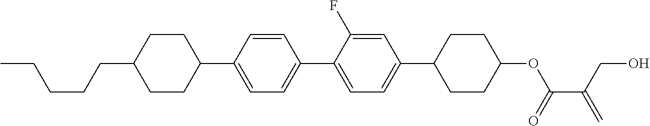 [SMILES: C=C(CO)C(=O)OC1CCC(c2ccc(-c3ccc(C4CCC(CCCCC)CC4)cc3)c(F)c2)CC1] |
| 1α-6-46 | 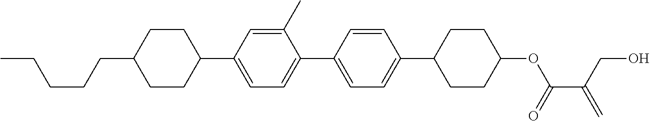 [SMILES: C=C(CO)C(=O)OC1CCC(c2ccc(-c3ccc(C4CCC(CCCCC)CC4)cc3C)cc2)CC1] |
| 1α-6-47 | 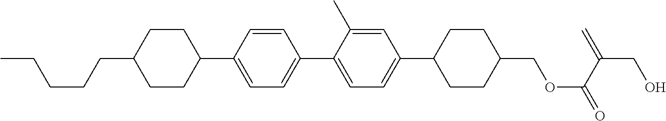 [SMILES: C=C(CO)C(=O)OCC1CCC(c2ccc(-c3ccc(C4CCC(CCCCC)CC4)cc3)c(C)c2)CC1] |
| 1α-6-48 | 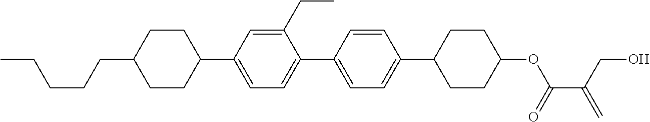 [SMILES: C=C(CO)C(=O)OC1CCC(c2ccc(-c3ccc(C4CCC(CCCCC)CC4)cc3CC)cc2)CC1] |
| 1α-6-49 | 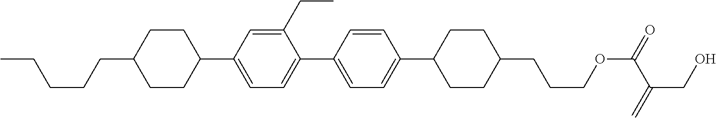 [SMILES: C=C(CO)C(=O)OCCCC1CCC(c2ccc(-c3ccc(C4CCC(CCCCC)CC4)cc3CC)cc2)CC1] |
| 1α-6-50 | 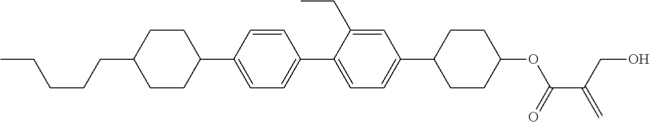 [SMILES: C=C(CO)C(=O)OC1CCC(c2ccc(-c3ccc(C4CCC(CCCCC)CC4)cc3)c(CC)c2)CC1] |
| 1α-6-51 | 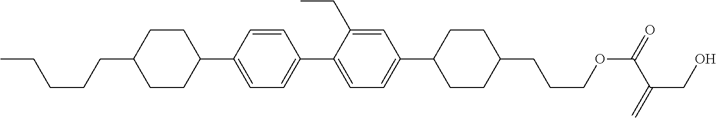 [SMILES: C=C(CO)C(=O)OCCCC1CCC(c2ccc(-c3ccc(C4CCC(CCCCC)CC4)cc3)c(CC)c2)CC1] |
| 1α-6-52 | 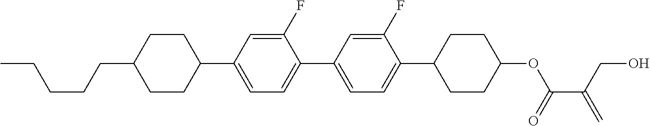 [SMILES: C=C(CO)C(=O)OC1CCC(c2ccc(-c3ccc(C4CCC(CCCCC)CC4)cc3F)cc2F)CC1] |
| 1α-6-53 | 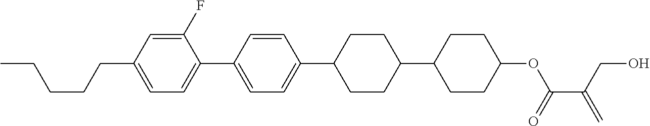 [SMILES: C=C(CO)C(=O)OC1CCC(C2CCC(c3ccc(-c4ccc(CCCCC)cc4F)cc3)CC2)CC1] |
| 1α-6-54 | 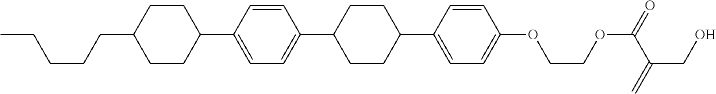 [SMILES: C=C(CO)C(=O)OCCOc1ccc(C2CCC(c3ccc(C4CCC(CCCCC)CC4)cc3)CC2)cc1] |
| 1α-6-55 | 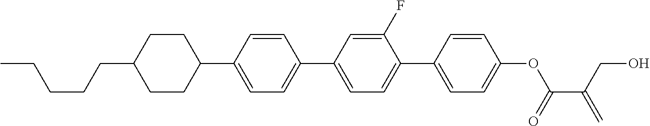 [SMILES: C=C(CO)C(=O)Oc1ccc(-c2ccc(-c3ccc(C4CCC(CCCCC)CC4)cc3)cc2F)cc1] |
| 1α-6-56 | 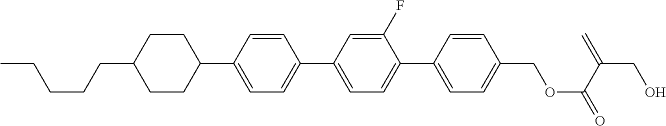 [SMILES: C=C(CO)C(=O)OCc1ccc(-c2ccc(-c3ccc(C4CCC(CCCCC)CC4)cc3)cc2F)cc1] |
| 1α-6-57 | 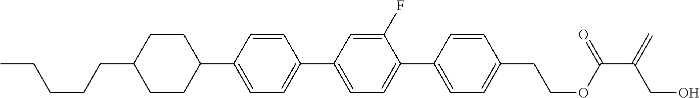 [SMILES: C=C(CO)C(=O)OCCc1ccc(-c2ccc(-c3ccc(C4CCC(CCCCC)CC4)cc3)cc2F)cc1] |
| 1α-6-58 | 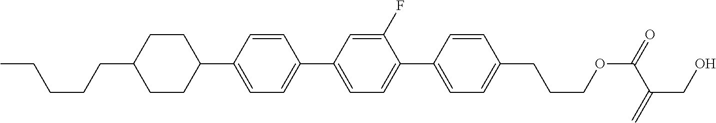 [SMILES: C=C(CO)C(=O)OCCCc1ccc(-c2ccc(-c3ccc(C4CCC(CCCCC)CC4)cc3)cc2F)cc1] |
| 1α-6-59 | 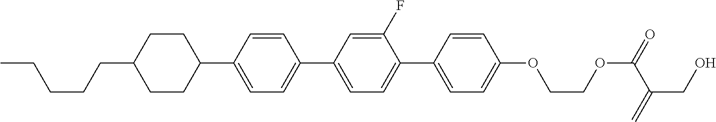 [SMILES: C=C(CO)C(=O)OCCOc1ccc(-c2ccc(-c3ccc(C4CCC(CCCCC)CC4)cc3)cc2F)cc1] |
| 1α-6-60 | 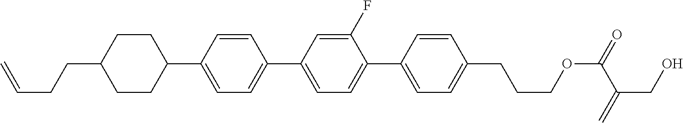 [SMILES: C=CCCC1CCC(c2ccc(-c3ccc(-c4ccc(CCCOC(=O)C(=C)CO)cc4)c(F)c3)cc2)CC1] |
| 1α-6-61 | 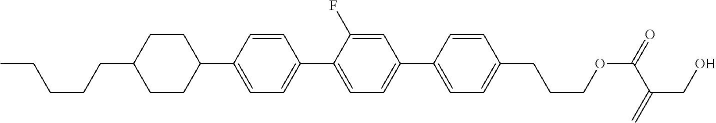 [SMILES: C=C(CO)C(=O)OCCCc1ccc(-c2ccc(-c3ccc(C4CCC(CCCCC)CC4)cc3)c(F)c2)cc1] |
| 1α-6-62 | 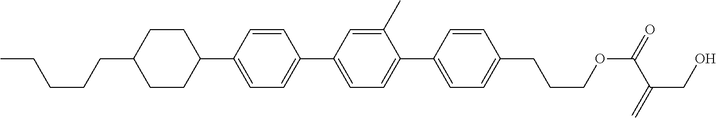 [SMILES: C=C(CO)C(=O)OCCCc1ccc(-c2ccc(-c3ccc(C4CCC(CCCCC)CC4)cc3)cc2C)cc1] |
| 1α-6-63 | 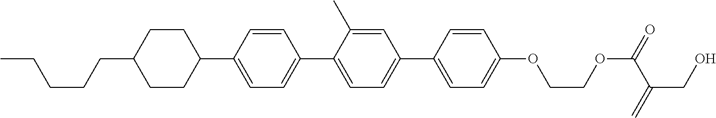 [SMILES: C=C(CO)C(=O)OCCOc1ccc(-c2ccc(-c3ccc(C4CCC(CCCCC)CC4)cc3)c(C)c2)cc1] |
| 1α-6-64 | 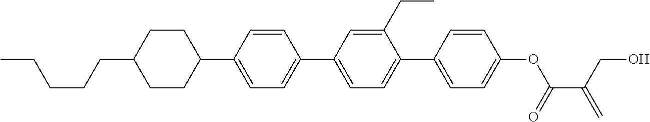 [SMILES: C=C(CO)C(=O)Oc1ccc(-c2ccc(-c3ccc(C4CCC(CCCCC)CC4)cc3)cc2CC)cc1] |
| 1α-6-65 | 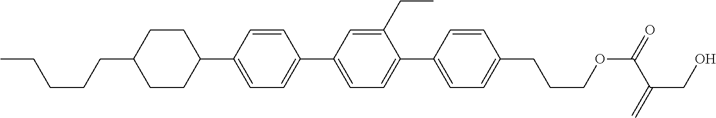 [SMILES: C=C(CO)C(=O)OCCCc1ccc(-c2ccc(-c3ccc(C4CCC(CCCCC)CC4)cc3)cc2CC)cc1] |
| 1α-6-66 | 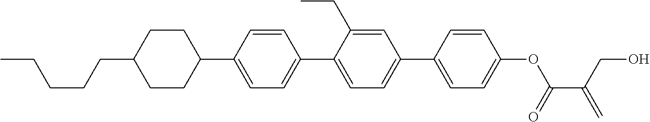 [SMILES: C=C(CO)C(=O)Oc1ccc(-c2ccc(-c3ccc(C4CCC(CCCCC)CC4)cc3)c(CC)c2)cc1] |
| 1α-6-67 | 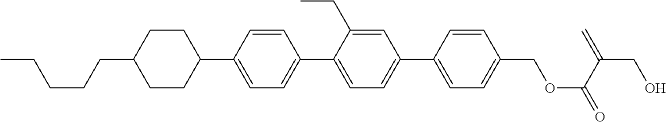 [SMILES: C=C(CO)C(=O)OCc1ccc(-c2ccc(-c3ccc(C4CCC(CCCCC)CC4)cc3)c(CC)c2)cc1] |
| 1α-6-68 | 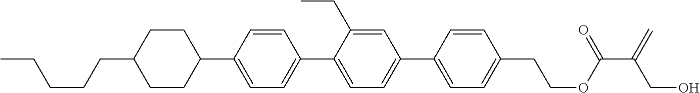 [SMILES: C=C(CO)C(=O)OCCc1ccc(-c2ccc(-c3ccc(C4CCC(CCCCC)CC4)cc3)c(CC)c2)cc1] |
| 1α-6-69 | 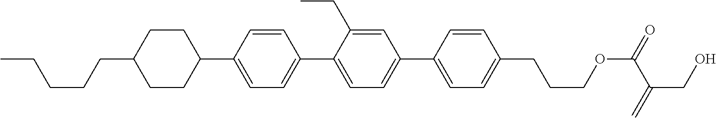 [SMILES: C=C(CO)C(=O)OCCCc1ccc(-c2ccc(-c3ccc(C4CCC(CCCCC)CC4)cc3)c(CC)c2)cc1] |
| 1α-6-70 | 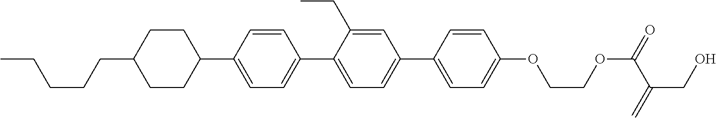 [SMILES: C=C(CO)C(=O)OCCOc1ccc(-c2ccc(-c3ccc(C4CCC(CCCCC)CC4)cc3)c(CC)c2)cc1] |
| 1α-6-71 | 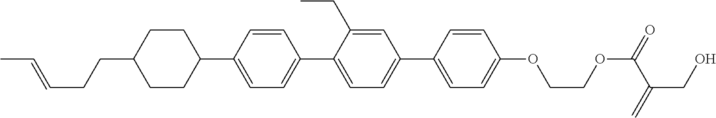 [SMILES: C=C(CO)C(=O)OCCOc1ccc(-c2ccc(-c3ccc(C4CCC(CC/C=C/C)CC4)cc3)c(CC)c2)cc1] |
| 1α-6-72 | 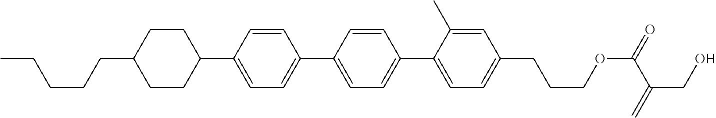 [SMILES: C=C(CO)C(=O)OCCCc1ccc(-c2ccc(-c3ccc(C4CCC(CCCCC)CC4)cc3)cc2)c(C)c1] |
| 1α-6-73 | 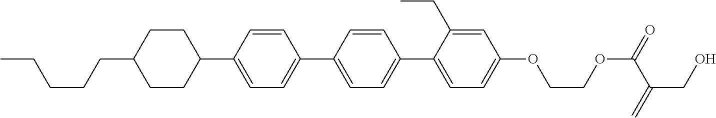 [SMILES: C=C(CO)C(=O)OCCOc1ccc(-c2ccc(-c3ccc(C4CCC(CCCCC)CC4)cc3)cc2)c(CC)c1] |
| 1α-6-74 | 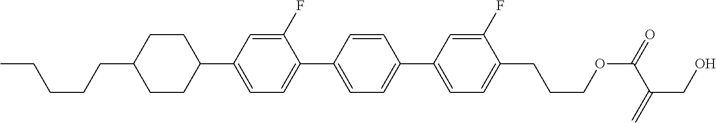 [SMILES: C=C(CO)C(=O)OCCCc1ccc(-c2ccc(-c3ccc(C4CCC(CCCCC)CC4)cc3F)cc2)cc1F] |
| 1α-6-75 | 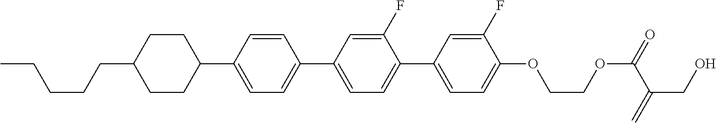 [SMILES: C=C(CO)C(=O)OCCOc1ccc(-c2ccc(-c3ccc(C4CCC(CCCCC)CC4)cc3)cc2F)cc1F] |
| 1α-6-76 | 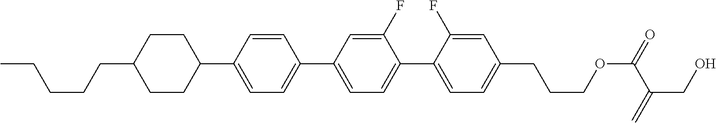 [SMILES: C=C(CO)C(=O)OCCCc1ccc(-c2ccc(-c3ccc(C4CCC(CCCCC)CC4)cc3)cc2F)c(F)c1] |
| 1α-6-77 | 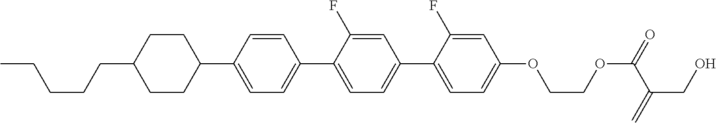 [SMILES: C=C(CO)C(=O)OCCOc1ccc(-c2ccc(-c3ccc(C4CCC(CCCCC)CC4)cc3)c(F)c2)c(F)c1] |
| 1α-6-78 | 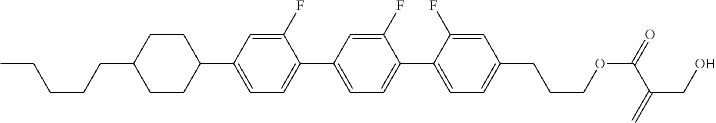 [SMILES: C=C(CO)C(=O)OCCCc1ccc(-c2ccc(-c3ccc(C4CCC(CCCCC)CC4)cc3F)cc2F)c(F)c1] |
| 1α-6-79 | 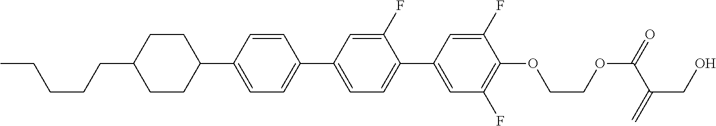 [SMILES: C=C(CO)C(=O)OCCOc1c(F)cc(-c2ccc(-c3ccc(C4CCC(CCCCC)CC4)cc3)cc2F)cc1F] |
| 1α-6-80 | 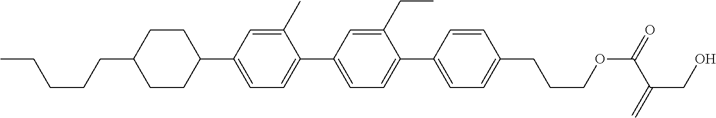 [SMILES: C=C(CO)C(=O)OCCCc1ccc(-c2ccc(-c3ccc(C4CCC(CCCCC)CC4)cc3C)cc2CC)cc1] |
| 1α-6-81 | 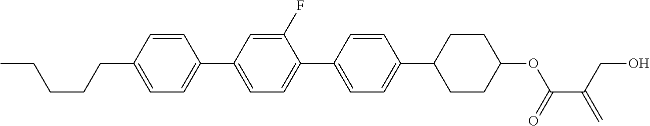 [SMILES: C=C(CO)C(=O)OC1CCC(c2ccc(-c3ccc(-c4ccc(CCCCC)cc4)cc3F)cc2)CC1] |
| 1α-6-82 | 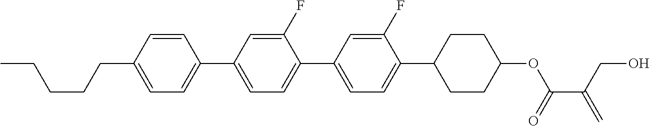 [SMILES: C=C(CO)C(=O)OC1CCC(c2ccc(-c3ccc(-c4ccc(CCCCC)cc4)cc3F)cc2F)CC1] |
| 1α-6-83 | 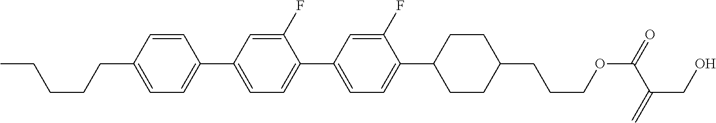 [SMILES: C=C(CO)C(=O)OCCCC1CCC(c2ccc(-c3ccc(-c4ccc(CCCCC)cc4)cc3F)cc2F)CC1] |
| 1α-6-84 | 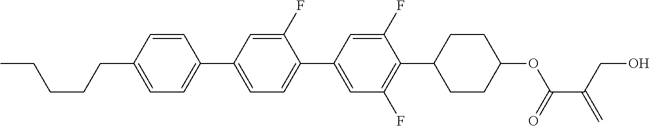 [SMILES: C=C(CO)C(=O)OC1CCC(c2c(F)cc(-c3ccc(-c4ccc(CCCCC)cc4)cc3F)cc2F)CC1] |
| 1α-6-85 | 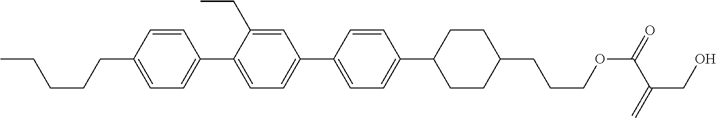 [SMILES: C=C(CO)C(=O)OCCCC1CCC(c2ccc(-c3ccc(-c4ccc(CCCCC)cc4)c(CC)c3)cc2)CC1] |
| 1α-6-86 | 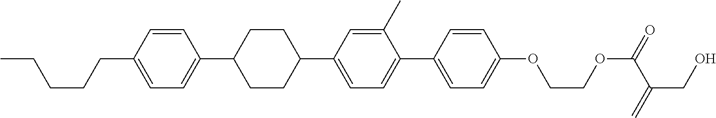 [SMILES: C=C(CO)C(=O)OCCOc1ccc(-c2ccc(C3CCC(c4ccc(CCCCC)cc4)CC3)cc2C)cc1] |
| 1α-6-87 | 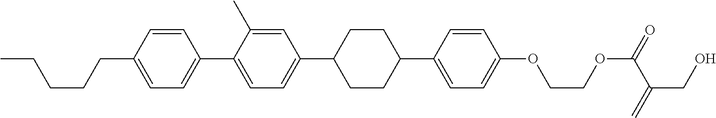 [SMILES: C=C(CO)C(=O)OCCOc1ccc(C2CCC(c3ccc(-c4ccc(CCCCC)cc4)c(C)c3)CC2)cc1] |
| 1α-6-88 | 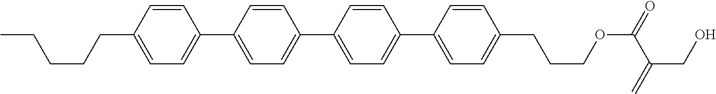 [SMILES: C=C(CO)C(=O)OCCCc1ccc(-c2ccc(-c3ccc(-c4ccc(CCCCC)cc4)cc3)cc2)cc1] |
| 1α-6-89 | 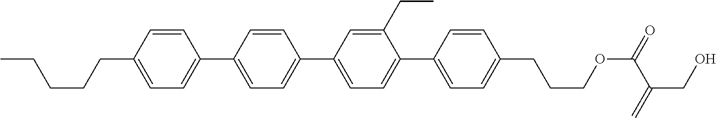 [SMILES: C=C(CO)C(=O)OCCCc1ccc(-c2ccc(-c3ccc(-c4ccc(CCCCC)cc4)cc3)cc2CC)cc1] |
| 1α-6-90 | 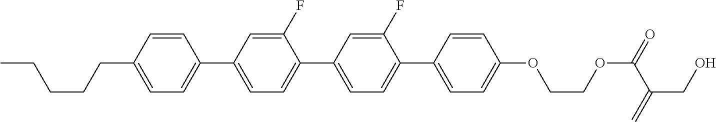 [SMILES: C=C(CO)C(=O)OCCOc1ccc(-c2ccc(-c3ccc(-c4ccc(CCCCC)cc4)cc3F)cc2F)cc1] |
| 1α-6-91 | 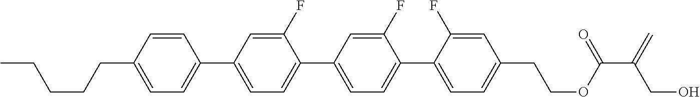 [SMILES: C=C(CO)C(=O)OCCc1ccc(-c2ccc(-c3ccc(-c4ccc(CCCCC)cc4)cc3F)cc2F)c(F)c1] |
| 1α-6-92 | 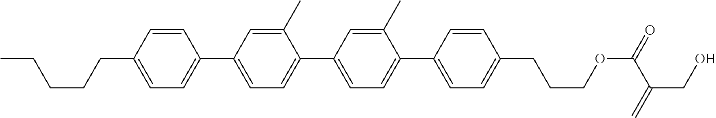 [SMILES: C=C(CO)C(=O)OCCCc1ccc(-c2ccc(-c3ccc(-c4ccc(CCCCC)cc4)cc3C)cc2C)cc1] |
| 1α-6-93 | 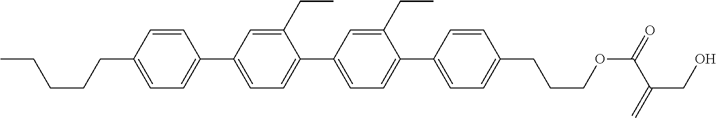 [SMILES: C=C(CO)C(=O)OCCCc1ccc(-c2ccc(-c3ccc(-c4ccc(CCCCC)cc4)cc3CC)cc2CC)cc1] |
| 1α-6-94 | 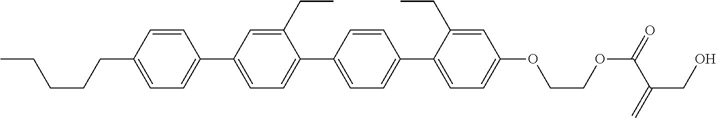 [SMILES: C=C(CO)C(=O)OCCOc1ccc(-c2ccc(-c3ccc(-c4ccc(CCCCC)cc4)cc3CC)cc2)c(CC)c1] |
| 1α-6-95 | 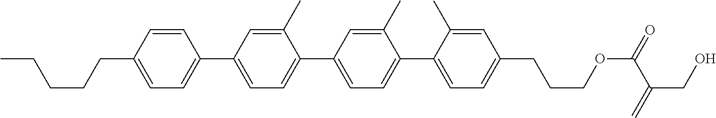 [SMILES: C=C(CO)C(=O)OCCCc1ccc(-c2ccc(-c3ccc(-c4ccc(CCCCC)cc4)cc3C)cc2C)c(C)c1] |
| 1α-6-96 | 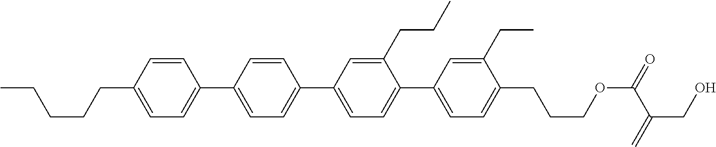 [SMILES: C=C(CO)C(=O)OCCCc1ccc(-c2ccc(-c3ccc(-c4ccc(CCCCC)cc4)cc3)cc2CCC)cc1CC] |
| 1α-6-97 | 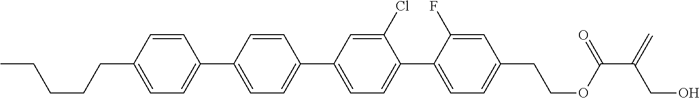 [SMILES: C=C(CO)C(=O)OCCc1ccc(-c2ccc(-c3ccc(-c4ccc(CCCCC)cc4)cc3)cc2Cl)c(F)c1] |
| 1α-6-98 | 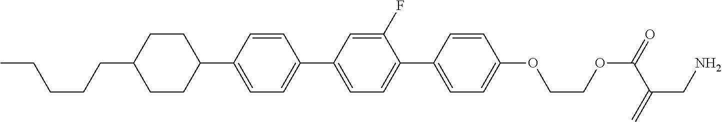 [SMILES: C=C(CN)C(=O)OCCOc1ccc(-c2ccc(-c3ccc(C4CCC(CCCCC)CC4)cc3)cc2F)cc1] |
| 1α-6-99 | 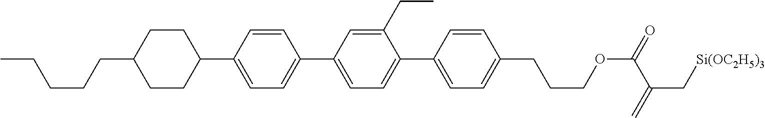 |
| 1α-6-100 | 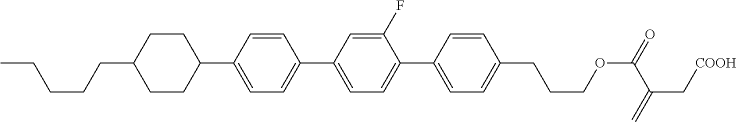 [SMILES: C=C(CC(=O)O)C(=O)OCCCc1ccc(-c2ccc(-c3ccc(C4CCC(CCCCC)CC4)cc3)cc2F)cc1] |
| 1α-6-101 | 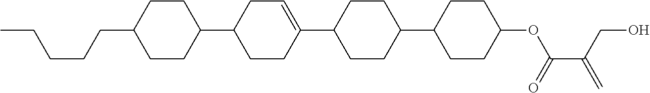 [SMILES: C=C(CO)C(=O)OC1CCC(C2CCC(C3=CCC(C4CCC(CCCCC)CC4)CC3)CC2)CC1] |
| 1α-6-102 | 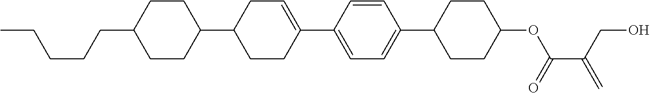 [SMILES: C=C(CO)C(=O)OC1CCC(c2ccc(C3=CCC(C4CCC(CCCCC)CC4)CC3)cc2)CC1] |
| 1α-6-103 | 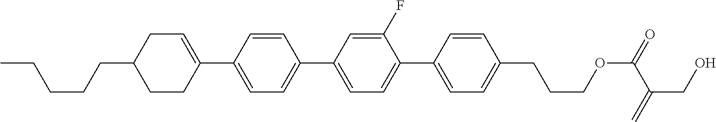 [SMILES: C=C(CO)C(=O)OCCCc1ccc(-c2ccc(-c3ccc(C4=CCC(CCCCC)CC4)cc3)cc2F)cc1] |
| 1α-6-104 | 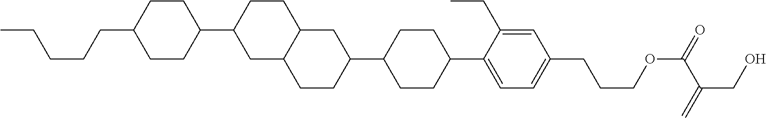 [SMILES: C=C(CO)C(=O)OCCCc1ccc(C2CCC(C3CCC4CC(C5CCC(CCCCC)CC5)CCC4C3)CC2)c(CC)c1] |
| 1α-6-105 | 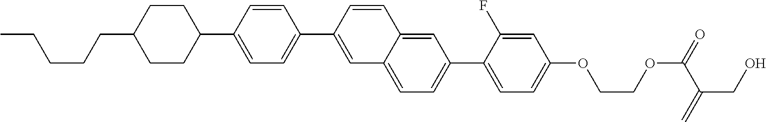 [SMILES: C=C(CO)C(=O)OCCOc1ccc(-c2ccc3cc(-c4ccc(C5CCC(CCCCC)CC5)cc4)ccc3c2)c(F)c1] |
| 1α-6-106 | 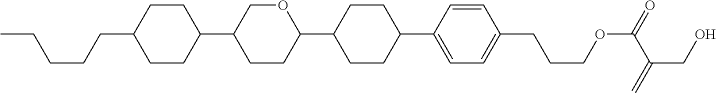 [SMILES: C=C(CO)C(=O)OCCCc1ccc(C2CCC(C3CCC(C4CCC(CCCCC)CC4)CO3)CC2)cc1] |
| 1α-6-107 | 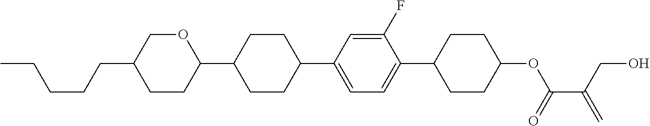 [SMILES: C=C(CO)C(=O)OC1CCC(c2ccc(C3CCC(C4CCC(CCCCC)CO4)CC3)cc2F)CC1] |
| 1α-6-108 | 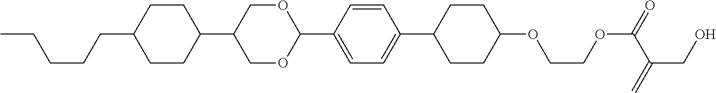 [SMILES: C=C(CO)C(=O)OCCOC1CCC(c2ccc(C3OCC(C4CCC(CCCCC)CC4)CO3)cc2)CC1] |
| 1α-6-109 | 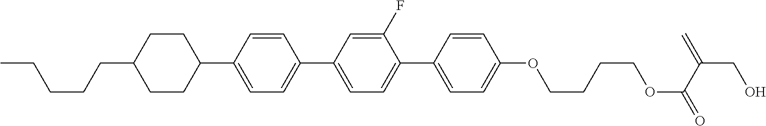 [SMILES: C=C(CO)C(=O)OCCCCOc1ccc(-c2ccc(-c3ccc(C4CCC(CCCCC)CC4)cc3)cc2F)cc1] |
| 1α-6-110 | 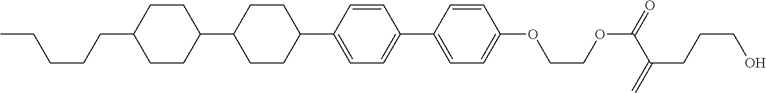 [SMILES: C=C(CCCO)C(=O)OCCOc1ccc(-c2ccc(C3CCC(C4CCC(CCCCC)CC4)CC3)cc2)cc1] |
| 1α-6-111 | 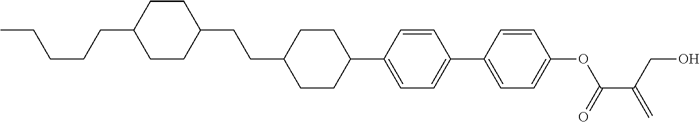 [SMILES: C=C(CO)C(=O)Oc1ccc(-c2ccc(C3CCC(CCC4CCC(CCCCC)CC4)CC3)cc2)cc1] |
| 1α-6-112 | 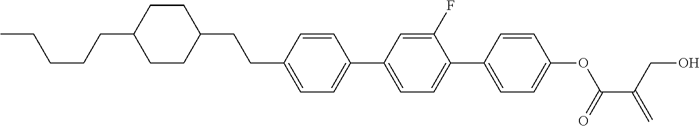 [SMILES: C=C(CO)C(=O)Oc1ccc(-c2ccc(-c3ccc(CCC4CCC(CCCCC)CC4)cc3)cc2F)cc1] |
| 1α-6-113 | 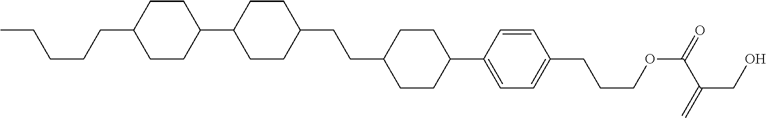 [SMILES: C=C(CO)C(=O)OCCCc1ccc(C2CCC(CCC3CCC(C4CCC(CCCCC)CC4)CC3)CC2)cc1] |
| 1a-6-114 | 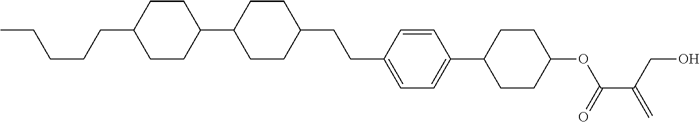 [SMILES: C=C(CO)C(=O)OC1CCC(c2ccc(CCC3CCC(C4CCC(CCCCC)CC4)CC3)cc2)CC1] |
| 1α-6-115 | 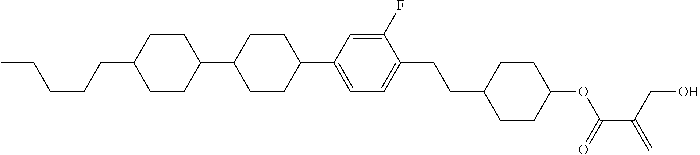 [SMILES: C=C(CO)C(=O)OC1CCC(CCc2ccc(C3CCC(C4CCC(CCCCC)CC4)CC3)cc2F)CC1] |
| 1α-6-116 | 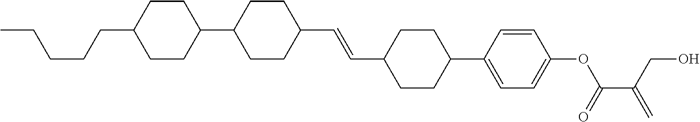 [SMILES: C=C(CO)C(=O)Oc1ccc(C2CCC(/C=C/C3CCC(C4CCC(CCCCC)CC4)CC3)CC2)cc1] |
| 1α-6-117 | 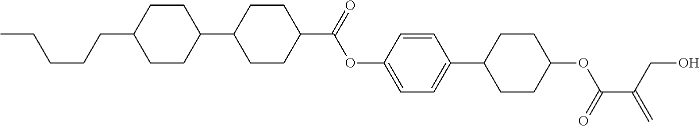 [SMILES: C=C(CO)C(=O)OC1CCC(c2ccc(OC(=O)C3CCC(C4CCC(CCCCC)CC4)CC3)cc2)CC1] |
| 1α-6-118 | 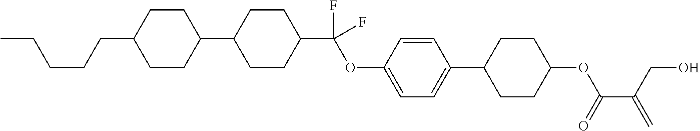 [SMILES: C=C(CO)C(=O)OC1CCC(c2ccc(OC(F)(F)C3CCC(C4CCC(CCCCC)CC4)CC3)cc2)CC1] |
| 1α-6-119 | 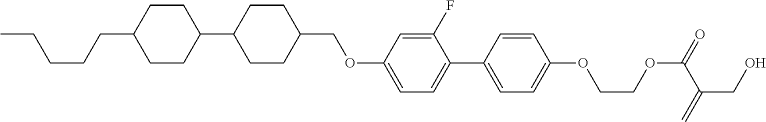 [SMILES: C=C(CO)C(=O)OCCOc1ccc(-c2ccc(OCC3CCC(C4CCC(CCCCC)CC4)CC3)cc2F)cc1] |
| 1a-6-120 | 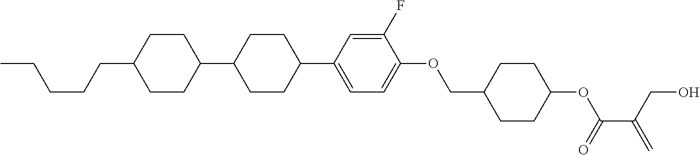 [SMILES: C=C(CO)C(=O)OC1CCC(COc2ccc(C3CCC(C4CCC(CCCCC)CC4)CC3)cc2F)CC1] |
| 1α-6-121 | 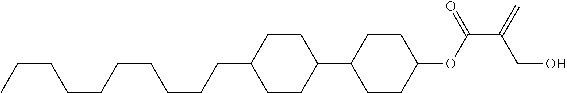 [SMILES: C=C(CO)C(=O)OC1CCC(C2CCC(CCCCCCCCCC)CC2)CC1] |
| 1α-6-122 | 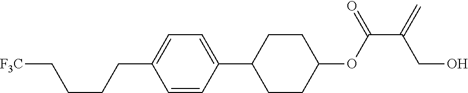 [SMILES: C=C(CO)C(=O)OC1CCC(c2ccc(CCCCC(F)(F)F)cc2)CC1] |
| 1α-6-123 | 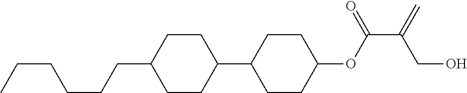 [SMILES: C=C(CO)C(=O)OC1CCC(C2CCC(CCCCCC)CC2)CC1] |
| 1α-6-124 | 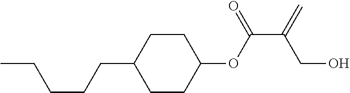 [SMILES: C=C(CO)C(=O)OC1CCC(CCCCC)CC1] |
| 1α-6-125 | 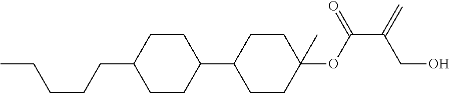 [SMILES: C=C(CO)C(=O)OC1(C)CCC(C2CCC(CCCCC)CC2)CC1] |
| 1α-6-126 | 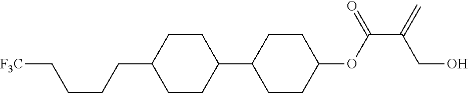 [SMILES: C=C(CO)C(=O)OC1CCC(C2CCC(CCCCC(F)(F)F)CC2)CC1] |
| 1α-6-127 | 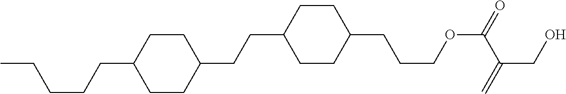 [SMILES: C=C(CO)C(=O)OCCCC1CCC(CCC2CCC(CCCCC)CC2)CC1] |
| 1α-6-128 | 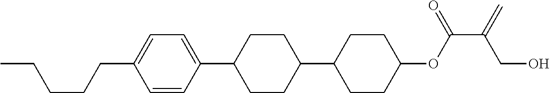 [SMILES: C=C(CO)C(=O)OC1CCC(C2CCC(c3ccc(CCCCC)cc3)CC2)CC1] |
| 1α-6-129 | 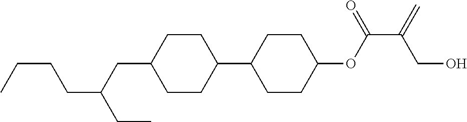 [SMILES: C=C(CO)C(=O)OC1CCC(C2CCC(CC(CC)CCCC)CC2)CC1] |
| 1α-6-130 | 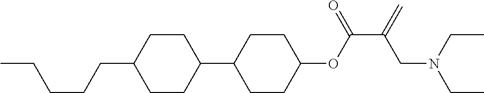 [SMILES: C=C(CN(CC)CC)C(=O)OC1CCC(C2CCC(CCCCC)CC2)CC1] |
| 1α-6-131 | 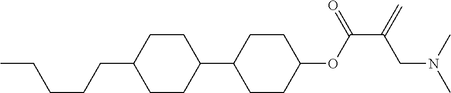 [SMILES: C=C(CN(C)C)C(=O)OC1CCC(C2CCC(CCCCC)CC2)CC1] |
| 1α-6-132 | 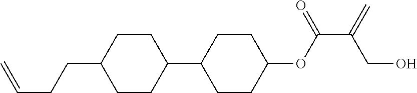 [SMILES: C=CCCC1CCC(C2CCC(OC(=O)C(=C)CO)CC2)CC1] |
| 1α-6-133 | 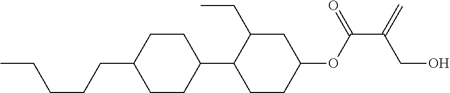 [SMILES: C=C(CO)C(=O)OC1CCC(C2CCC(CCCCC)CC2)C(CC)C1] |
| 1α-6-134 | 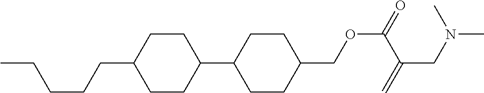 [SMILES: C=C(CN(C)C)C(=O)OCC1CCC(C2CCC(CCCCC)CC2)CC1] |
| 1α-6-135 | 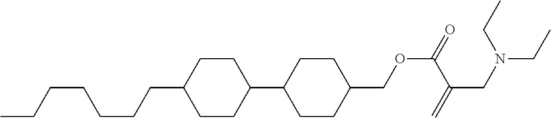 [SMILES: C=C(CN(CC)CC)C(=O)OCC1CCC(C2CCC(CCCCCCC)CC2)CC1] |
| 1α-6-136 | 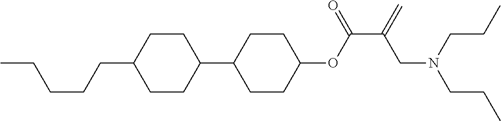 [SMILES: C=C(CN(CCC)CCC)C(=O)OC1CCC(C2CCC(CCCCC)CC2)CC1] |
| 1α-6-137 | 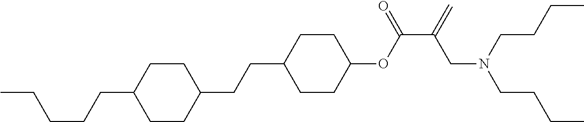 [SMILES: C=C(CN(CCCC)CCCC)C(=O)OC1CCC(CCC2CCC(CCCCC)CC2)CC1] |
| 1α-6-138 | 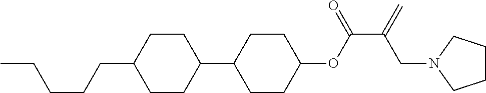 [SMILES: C=C(CN1CCCC1)C(=O)OC1CCC(C2CCC(CCCCC)CC2)CC1] |
| 1α-6-139 | 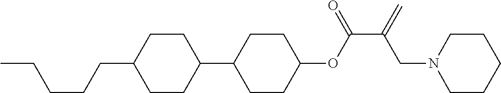 [SMILES: C=C(CN1CCCCC1)C(=O)OC1CCC(C2CCC(CCCCC)CC2)CC1] |
| 1α-6-140 | 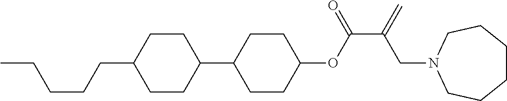 [SMILES: C=C(CN1CCCCCC1)C(=O)OC1CCC(C2CCC(CCCCC)CC2)CC1] |
| 1α-6-141 | 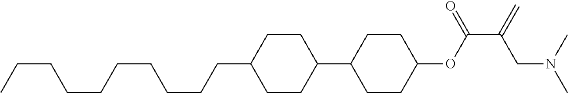 [SMILES: C=C(CN(C)C)C(=O)OC1CCC(C2CCC(CCCCCCCCCC)CC2)CC1] |
| 1α-6-142 | 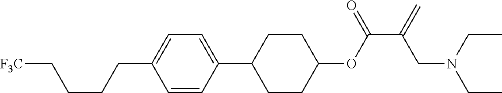 [SMILES: C=C(CN(CC)CC)C(=O)OC1CCC(c2ccc(CCCCC(F)(F)F)cc2)CC1] |
| 1α-6-143 | 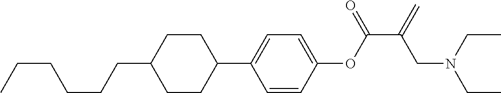 [SMILES: C=C(CN(CC)CC)C(=O)Oc1ccc(C2CCC(CCCCCC)CC2)cc1] |
| 1α-6-144 | 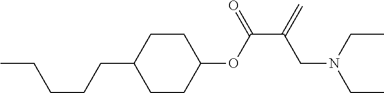 [SMILES: C=C(CN(CC)CC)C(=O)OC1CCC(CCCCC)CC1] |
| 1α-6-145 | 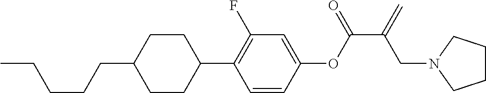 [SMILES: C=C(CN1CCCC1)C(=O)Oc1ccc(C2CCC(CCCCC)CC2)c(F)c1] |
| 1α-6-146 | 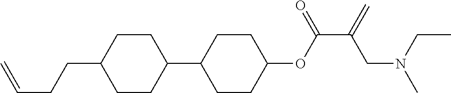 [SMILES: C=CCCC1CCC(C2CCC(OC(=O)C(=C)CN(C)CC)CC2)CC1] |
| 1α-6-147 | 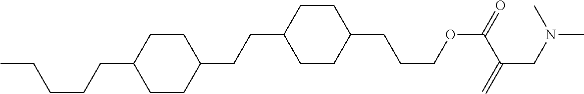 [SMILES: C=C(CN(C)C)C(=O)OCCCC1CCC(CCC2CCC(CCCCC)CC2)CC1] |
| 1α-6-148 | 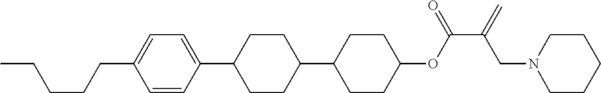 [SMILES: C=C(CN1CCCCC1)C(=O)OC1CCC(C2CCC(c3ccc(CCCCC)cc3)CC2)CC1] |
| 1α-6-149 | 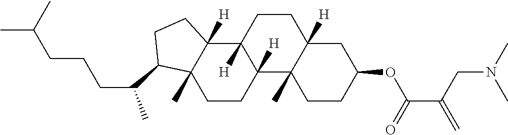 |
| 1α-6-150 | 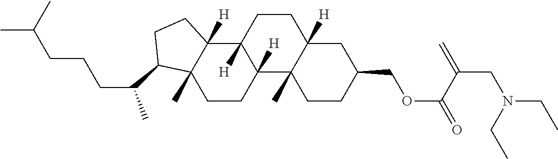 |
| 1α-6-151 | 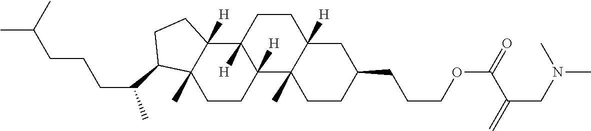 |
| 1α-6-152 | 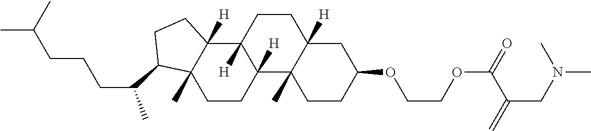 |
| 1α-6-153 | 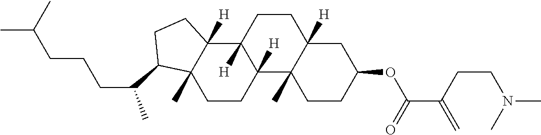 |
| 1α-6-154 | 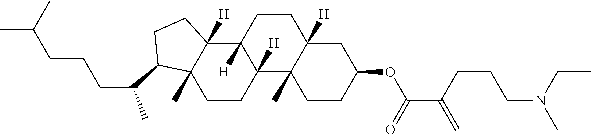 |
| 1α-6-155 | 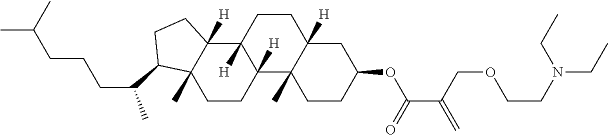 |
| 1α-6-156 | 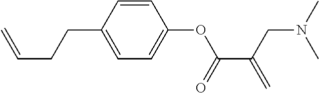 [SMILES: C=CCCc1ccc(OC(=O)C(=C)CN(C)C)cc1] |
| 1α-6-157 | 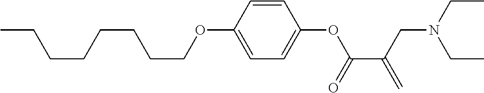 [SMILES: C=C(CN(CC)CC)C(=O)Oc1ccc(OCCCCCCCC)cc1] |
| 1α-6-158 | 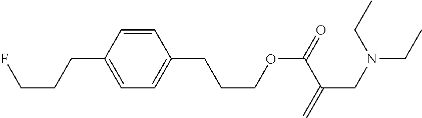 [SMILES: C=C(CN(CC)CC)C(=O)OCCCc1ccc(CCCF)cc1] |
| 1α-6-159 | 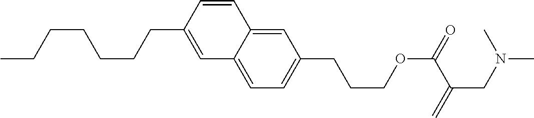 [SMILES: C=C(CN(C)C)C(=O)OCCCc1ccc2cc(CCCCCCC)ccc2c1] |
| 1α-6-160 | 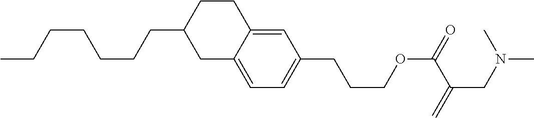 [SMILES: C=C(CN(C)C)C(=O)OCCCc1ccc2c(c1)CCC(CCCCCCC)C2] |
| 1α-6-161 | 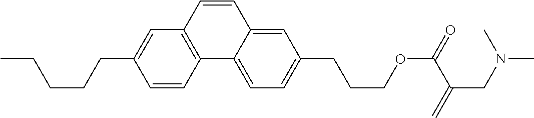 [SMILES: C=C(CN(C)C)C(=O)OCCCc1ccc2c(ccc3cc(CCCCC)ccc32)c1] |
| 1α-6-162 | 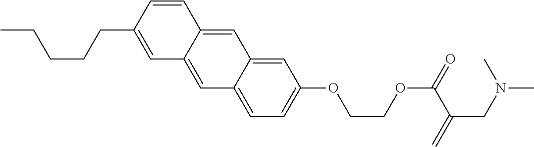 [SMILES: C=C(CN(C)C)C(=O)OCCOc1ccc2cc3cc(CCCCC)ccc3cc2c1] |
| 1α-6-163 | 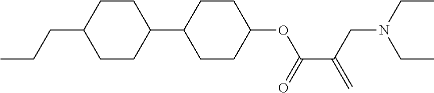 [SMILES: C=C(CN(CC)CC)C(=O)OC1CCC(C2CCC(CCC)CC2)CC1] |
| 1α-6-164 | 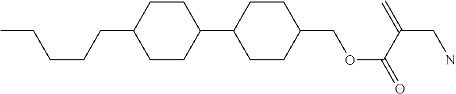 [SMILES: C=C(CN)C(=O)OCC1CCC(C2CCC(CCCCC)CC2)CC1] |
| 1α-6-165 | 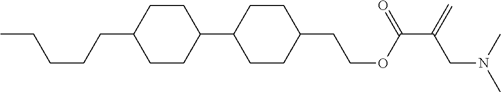 [SMILES: C=C(CN(C)C)C(=O)OCCC1CCC(C2CCC(CCCCC)CC2)CC1] |
| 1α-6-166 | 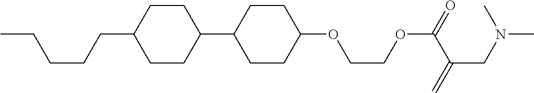 [SMILES: C=C(CN(C)C)C(=O)OCCOC1CCC(C2CCC(CCCCC)CC2)CC1] |
| 1α-6-167 | 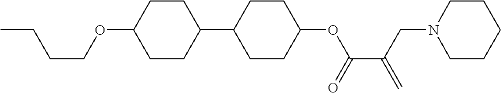 [SMILES: C=C(CN1CCCCC1)C(=O)OC1CCC(C2CCC(OCCCC)CC2)CC1] |
| 1α-6-168 | 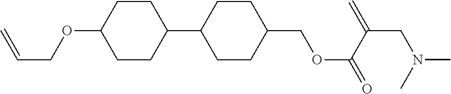 [SMILES: C=CCOC1CCC(C2CCC(COC(=O)C(=C)CN(C)C)CC2)CC1] |
| 1α-6-169 | 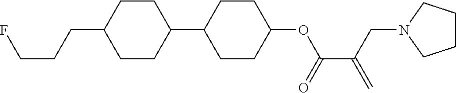 [SMILES: C=C(CN1CCCC1)C(=O)OC1CCC(C2CCC(CCCF)CC2)CC1] |
| 1α-6-170 | 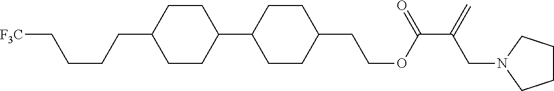 [SMILES: C=C(CN1CCCC1)C(=O)OCCC1CCC(C2CCC(CCCCC(F)(F)F)CC2)CC1] |
| 1α-6-171 | 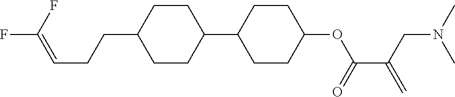 [SMILES: C=C(CN(C)C)C(=O)OC1CCC(C2CCC(CCC=C(F)F)CC2)CC1] |
| 1α-6-172 | 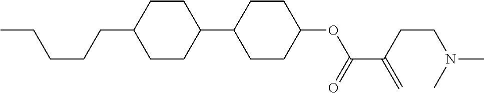 [SMILES: C=C(CCN(C)C)C(=O)OC1CCC(C2CCC(CCCCC)CC2)CC1] |
| 1α-6-173 | 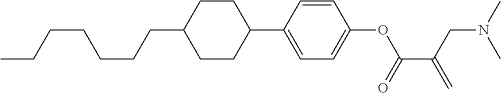 [SMILES: C=C(CN(C)C)C(=O)Oc1ccc(C2CCC(CCCCCCC)CC2)cc1] |
| 1α-6-174 | 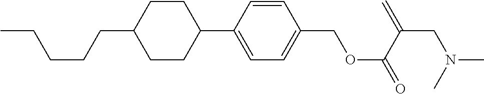 [SMILES: C=C(CN(C)C)C(=O)OCc1ccc(C2CCC(CCCCC)CC2)cc1] |
| 1α-6-175 | 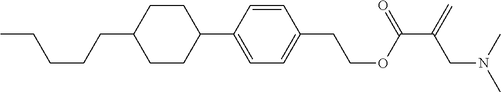 [SMILES: C=C(CN(C)C)C(=O)OCCc1ccc(C2CCC(CCCCC)CC2)cc1] |
| 1α-6-176 | 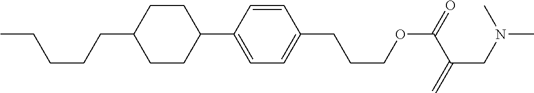 [SMILES: C=C(CN(C)C)C(=O)OCCCc1ccc(C2CCC(CCCCC)CC2)cc1] |
| 1α-6-177 | 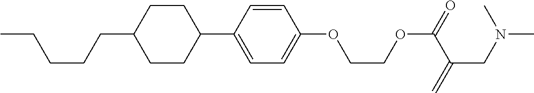 [SMILES: C=C(CN(C)C)C(=O)OCCOc1ccc(C2CCC(CCCCC)CC2)cc1] |
| 1α-6-178 | 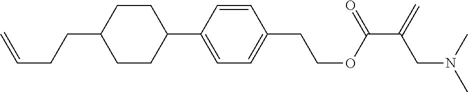 [SMILES: C=CCCC1CCC(c2ccc(CCOC(=O)C(=C)CN(C)C)cc2)CC1] |
| 1α-6-179 | 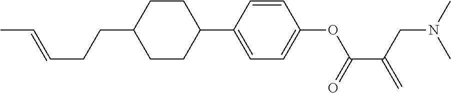 [SMILES: C=C(CN(C)C)C(=O)Oc1ccc(C2CCC(CC/C=C/C)CC2)cc1] |
| 1α-6-180 | 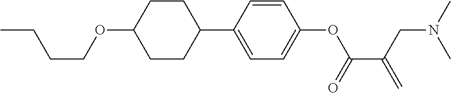 [SMILES: C=C(CN(C)C)C(=O)Oc1ccc(C2CCC(OCCCC)CC2)cc1] |
| 1α-6-181 | 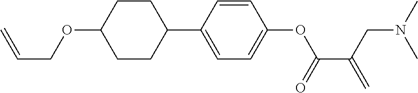 [SMILES: C=CCOC1CCC(c2ccc(OC(=O)C(=C)CN(C)C)cc2)CC1] |
| 1α-6-182 | 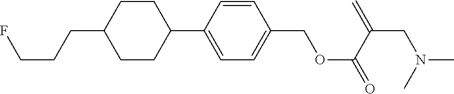 [SMILES: C=C(CN(C)C)C(=O)OCc1ccc(C2CCC(CCCF)CC2)cc1] |
| 1α-6-183 | 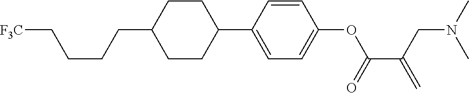 [SMILES: C=C(CN(C)C)C(=O)Oc1ccc(C2CCC(CCCCC(F)(F)F)CC2)cc1] |
| 1α-6-184 | 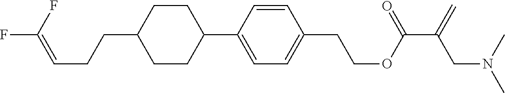 [SMILES: C=C(CN(C)C)C(=O)OCCc1ccc(C2CCC(CCC=C(F)F)CC2)cc1] |
| 1α-6-185 | 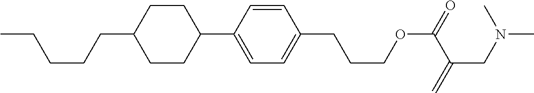 [SMILES: C=C(CN(C)C)C(=O)OCCCc1ccc(C2CCC(CCCCC)CC2)cc1] |
| 1α-6-186 | 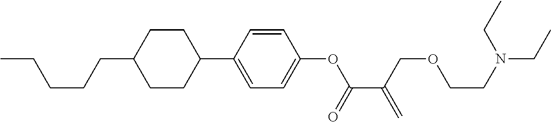 [SMILES: C=C(COCCN(CC)CC)C(=O)Oc1ccc(C2CCC(CCCCC)CC2)cc1] |
| 1α-6-187 | 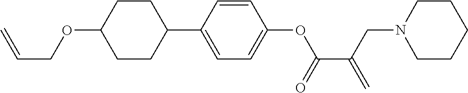 [SMILES: C=CCOC1CCC(c2ccc(OC(=O)C(=C)CN3CCCCC3)cc2)CC1] |
| 1α-6-188 | 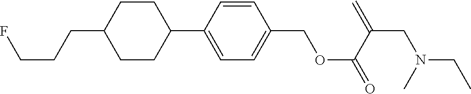 [SMILES: C=C(CN(C)CC)C(=O)OCc1ccc(C2CCC(CCCF)CC2)cc1] |
| 1α-6-189 | 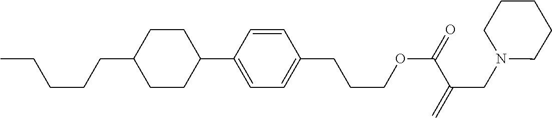 [SMILES: C=C(CN1CCCCC1)C(=O)OCCCc1ccc(C2CCC(CCCCC)CC2)cc1] |
| 1α-6-190 | 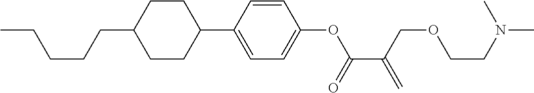 [SMILES: C=C(COCCN(C)C)C(=O)Oc1ccc(C2CCC(CCCCC)CC2)cc1] |
| 1α-6-191 | 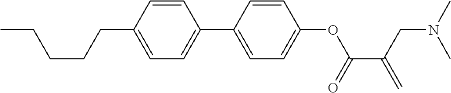 [SMILES: C=C(CN(C)C)C(=O)Oc1ccc(-c2ccc(CCCCC)cc2)cc1] |
| 1α-6-192 | 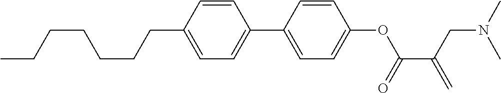 [SMILES: C=C(CN(C)C)C(=O)Oc1ccc(-c2ccc(CCCCCCC)cc2)cc1] |
| 1α-6-193 | 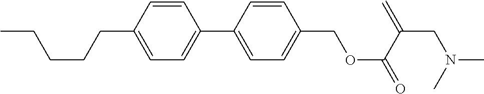 [SMILES: C=C(CN(C)C)C(=O)OCc1ccc(-c2ccc(CCCCC)cc2)cc1] |
| 1α-6-194 | 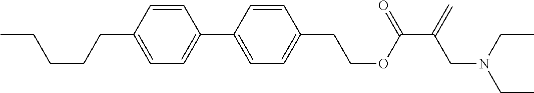 [SMILES: C=C(CN(CC)CC)C(=O)OCCc1ccc(-c2ccc(CCCCC)cc2)cc1] |
| 1α-6-195 | 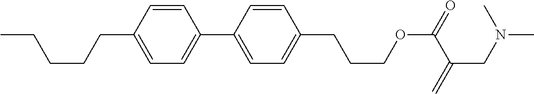 [SMILES: C=C(CN(C)C)C(=O)OCCCc1ccc(-c2ccc(CCCCC)cc2)cc1] |
| 1α-6-196 | 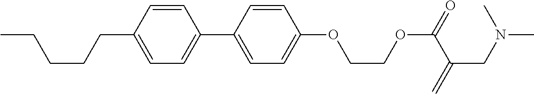 [SMILES: C=C(CN(C)C)C(=O)OCCOc1ccc(-c2ccc(CCCCC)cc2)cc1] |
| 1α-6-197 | 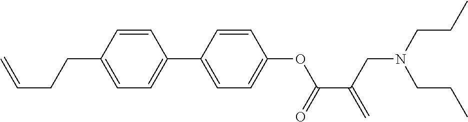 [SMILES: C=CCCc1ccc(-c2ccc(OC(=O)C(=C)CN(CCC)CCC)cc2)cc1] |
| 1α-6-198 | 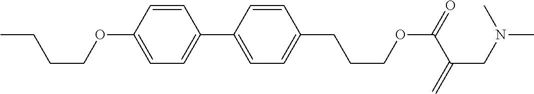 [SMILES: C=C(CN(C)C)C(=O)OCCCc1ccc(-c2ccc(OCCCC)cc2)cc1] |
| 1α-6-199 | 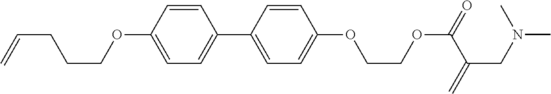 [SMILES: C=CCCCOc1ccc(-c2ccc(OCCOC(=O)C(=C)CN(C)C)cc2)cc1] |
| 1α-6-200 | 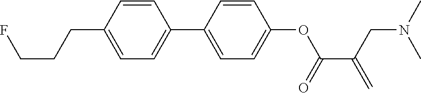 [SMILES: C=C(CN(C)C)C(=O)Oc1ccc(-c2ccc(CCCF)cc2)cc1] |
| 1α-6-201 | 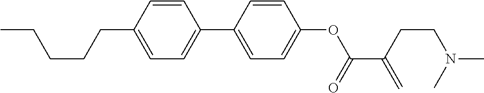 [SMILES: C=C(CCN(C)C)C(=O)Oc1ccc(-c2ccc(CCCCC)cc2)cc1] |
| 1α-6-202 | 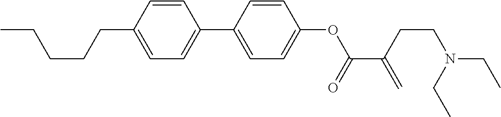 [SMILES: C=C(CCN(CC)CC)C(=O)Oc1ccc(-c2ccc(CCCCC)cc2)cc1] |
| 1α-6-203 | 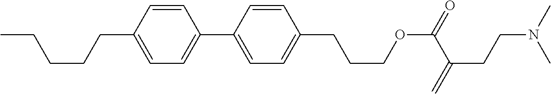 [SMILES: C=C(CCN(C)C)C(=O)OCCCc1ccc(-c2ccc(CCCCC)cc2)cc1] |
| 1α-6-204 | 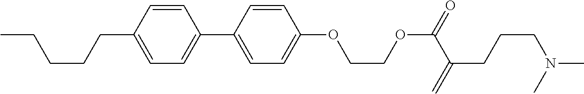 [SMILES: C=C(CCCN(C)C)C(=O)OCCOc1ccc(-c2ccc(CCCCC)cc2)cc1] |
| 1α-6-205 | 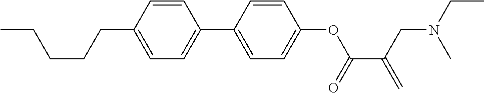 [SMILES: C=C(CN(C)CC)C(=O)Oc1ccc(-c2ccc(CCCCC)cc2)cc1] |
| 1α-6-206 | 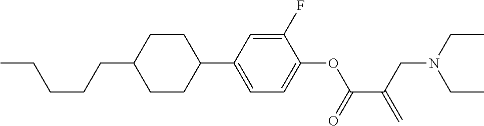 [SMILES: C=C(CN(CC)CC)C(=O)Oc1ccc(C2CCC(CCCCC)CC2)cc1F] |
| 1α-6-207 | 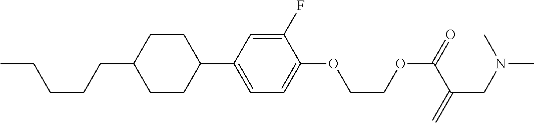 [SMILES: C=C(CN(C)C)C(=O)OCCOc1ccc(C2CCC(CCCCC)CC2)cc1F] |
| 1α-6-208 | 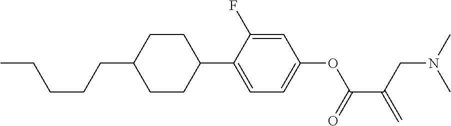 [SMILES: C=C(CN(C)C)C(=O)Oc1ccc(C2CCC(CCCCC)CC2)c(F)c1] |
| 1α-6-209 | 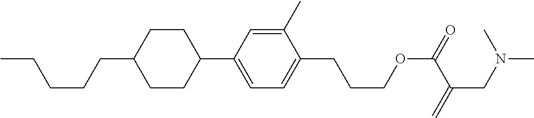 [SMILES: C=C(CN(C)C)C(=O)OCCCc1ccc(C2CCC(CCCCC)CC2)cc1C] |
| 1α-6-210 | 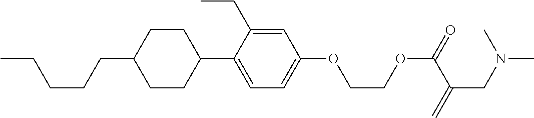 [SMILES: C=C(CN(C)C)C(=O)OCCOc1ccc(C2CCC(CCCCC)CC2)c(CC)c1] |
| 1α-6-211 | 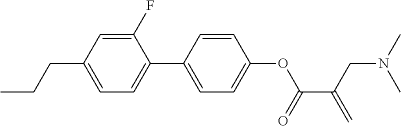 [SMILES: C=C(CN(C)C)C(=O)Oc1ccc(-c2ccc(CCC)cc2F)cc1] |
| 1α-6-212 | 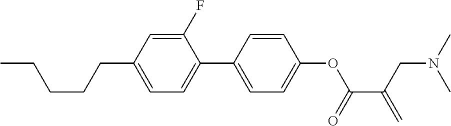 [SMILES: C=C(CN(C)C)C(=O)Oc1ccc(-c2ccc(CCCCC)cc2F)cc1] |
| 1α-6-213 | 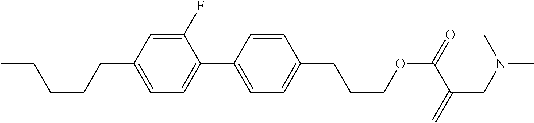 [SMILES: C=C(CN(C)C)C(=O)OCCCc1ccc(-c2ccc(CCCCC)cc2F)cc1] |
| 1α-6-214 | 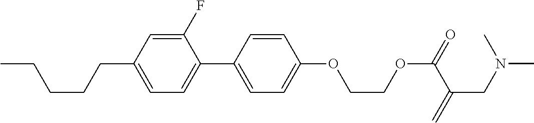 [SMILES: C=C(CN(C)C)C(=O)OCCOc1ccc(-c2ccc(CCCCC)cc2F)cc1] |
| 1α-6-215 | 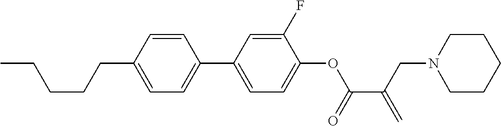 [SMILES: C=C(CN1CCCCC1)C(=O)Oc1ccc(-c2ccc(CCCCC)cc2)cc1F] |
| 1α-6-216 | 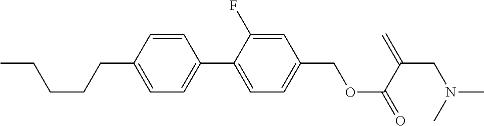 [SMILES: C=C(CN(C)C)C(=O)OCc1ccc(-c2ccc(CCCCC)cc2)c(F)c1] |
| 1α-6-217 | 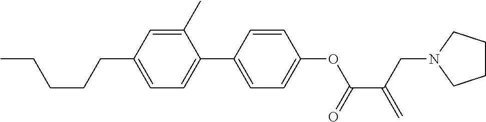 [SMILES: C=C(CN1CCCC1)C(=O)Oc1ccc(-c2ccc(CCCCC)cc2C)cc1] |
| 1α-6-218 | 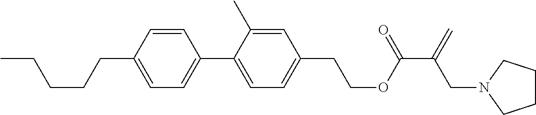 [SMILES: C=C(CN1CCCC1)C(=O)OCCc1ccc(-c2ccc(CCCCC)cc2)c(C)c1] |
| 1α-6-219 | 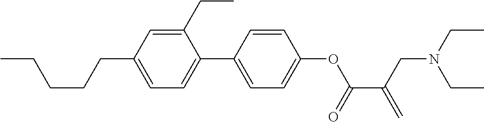 [SMILES: C=C(CN(CC)CC)C(=O)Oc1ccc(-c2ccc(CCCCC)cc2CC)cc1] |
| 1α-6-220 | 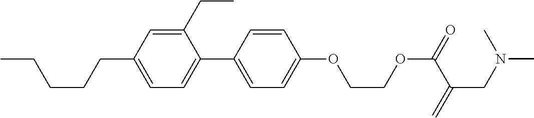 [SMILES: C=C(CN(C)C)C(=O)OCCOc1ccc(-c2ccc(CCCCC)cc2CC)cc1] |
| 1α-6-221 | 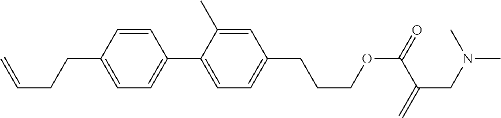 [SMILES: C=CCCc1ccc(-c2ccc(CCCOC(=O)C(=C)CN(C)C)cc2C)cc1] |
| 1α-6-222 | 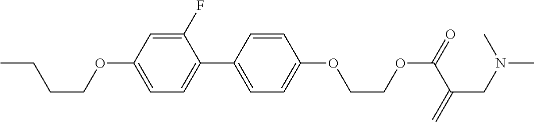 [SMILES: C=C(CN(C)C)C(=O)OCCOc1ccc(-c2ccc(OCCCC)cc2F)cc1] |
| 1α-6-223 | 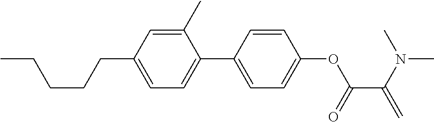 [SMILES: C=C(C(=O)Oc1ccc(-c2ccc(CCCCC)cc2C)cc1)N(C)C] |
| 1α-6-224 | 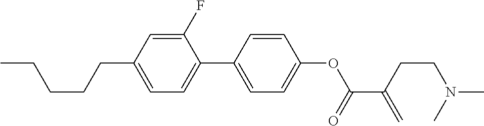 [SMILES: C=C(CCN(C)C)C(=O)Oc1ccc(-c2ccc(CCCCC)cc2F)cc1] |
| 1α-6-225 | 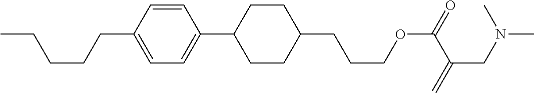 [SMILES: C=C(CN(C)C)C(=O)OCCCC1CCC(c2ccc(CCCCC)cc2)CC1] |
| 1α-6-226 | 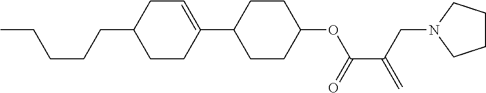 [SMILES: C=C(CN1CCCC1)C(=O)OC1CCC(C2=CCC(CCCCC)CC2)CC1] |
| 1α-6-227 | 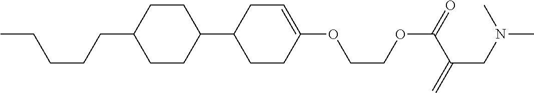 [SMILES: C=C(CN(C)C)C(=O)OCCOC1=CCC(C2CCC(CCCCC)CC2)CC1] |
| 1α-6-228 | 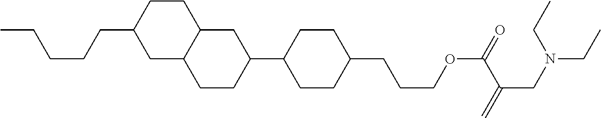 [SMILES: C=C(CN(CC)CC)C(=O)OCCCC1CCC(C2CCC3CC(CCCCC)CCC3C2)CC1] |
| 1α-6-229 | 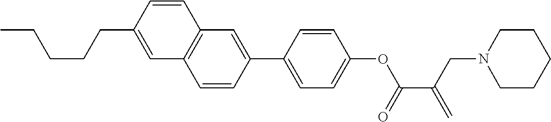 [SMILES: C=C(CN1CCCCC1)C(=O)Oc1ccc(-c2ccc3cc(CCCCC)ccc3c2)cc1] |
| 1α-6-230 | 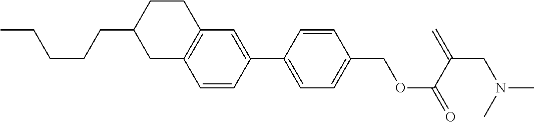 [SMILES: C=C(CN(C)C)C(=O)OCc1ccc(-c2ccc3c(c2)CCC(CCCCC)C3)cc1] |
| 1α-6-231 | 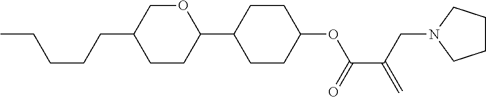 [SMILES: C=C(CN1CCCC1)C(=O)OC1CCC(C2CCC(CCCCC)CO2)CC1] |
| 1α-6-232 | 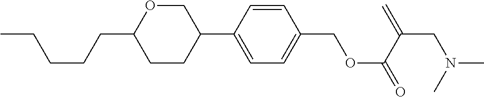 [SMILES: C=C(CN(C)C)C(=O)OCc1ccc(C2CCC(CCCCC)OC2)cc1] |
| 1α-6-233 | 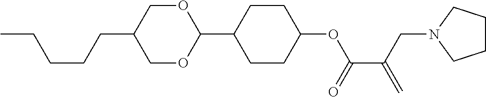 [SMILES: C=C(CN1CCCC1)C(=O)OC1CCC(C2OCC(CCCCC)CO2)CC1] |
| 1α-6-234 | 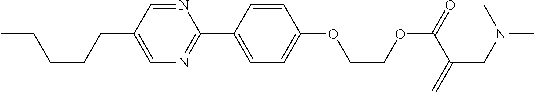 [SMILES: C=C(CN(C)C)C(=O)OCCOc1ccc(-c2ncc(CCCCC)cn2)cc1] |
| 1α-6-235 | 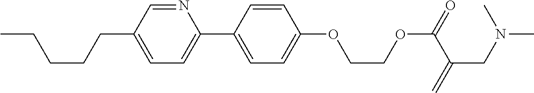 [SMILES: C=C(CN(C)C)C(=O)OCCOc1ccc(-c2ccc(CCCCC)cn2)cc1] |
| 1α-6-236 | 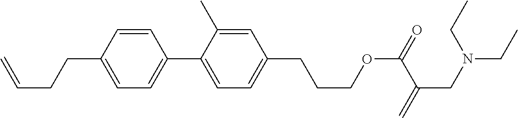 [SMILES: C=CCCc1ccc(-c2ccc(CCCOC(=O)C(=C)CN(CC)CC)cc2C)cc1] |
| 1α-6-237 | 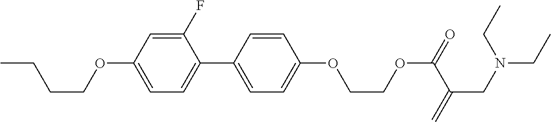 [SMILES: C=C(CN(CC)CC)C(=O)OCCOc1ccc(-c2ccc(OCCCC)cc2F)cc1] |
| 1α-6-238 | 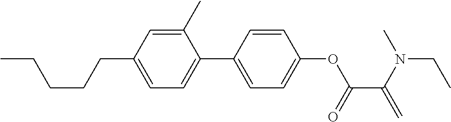 [SMILES: C=C(C(=O)Oc1ccc(-c2ccc(CCCCC)cc2C)cc1)N(C)CC] |
| 1α-6-239 | 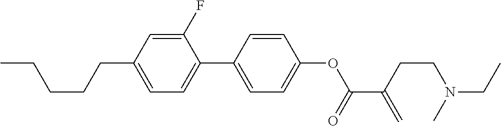 [SMILES: C=C(CCN(C)CC)C(=O)Oc1ccc(-c2ccc(CCCCC)cc2F)cc1] |
| 1α-6-240 | 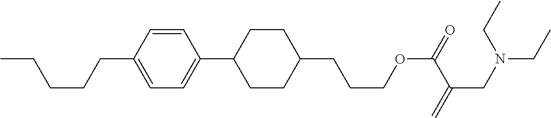 [SMILES: C=C(CN(CC)CC)C(=O)OCCCC1CCC(c2ccc(CCCCC)cc2)CC1] |
| 1α-6-241 | 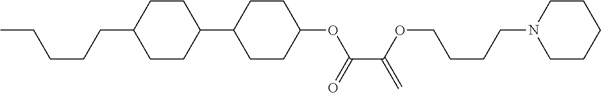 [SMILES: C=C(OCCCCN1CCCCC1)C(=O)OC1CCC(C2CCC(CCCCC)CC2)CC1] |
| 1α-6-242 | 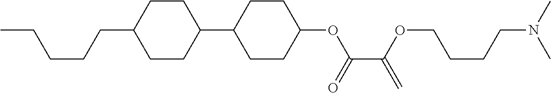 [SMILES: C=C(OCCCCN(C)C)C(=O)OC1CCC(C2CCC(CCCCC)CC2)CC1] |
| 1α-6-243 | 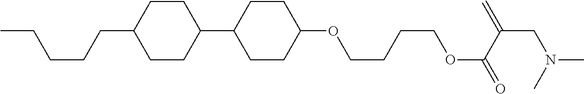 [SMILES: C=C(CN(C)C)C(=O)OCCCCOC1CCC(C2CCC(CCCCC)CC2)CC1] |
| 1α-6-244 | 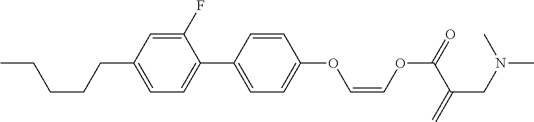 [SMILES: C=C(CN(C)C)C(=O)O/C=C\Oc1ccc(-c2ccc(CCCCC)cc2F)cc1] |
| 1α-6-245 | 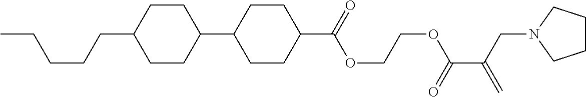 [SMILES: C=C(CN1CCCC1)C(=O)OCCOC(=O)C1CCC(C2CCC(CCCCC)CC2)CC1] |
| 1α-6-246 | 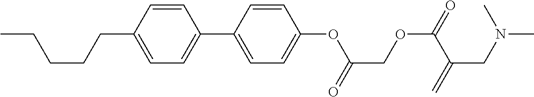 [SMILES: C=C(CN(C)C)C(=O)OCC(=O)Oc1ccc(-c2ccc(CCCCC)cc2)cc1] |
| 1α-6-247 | 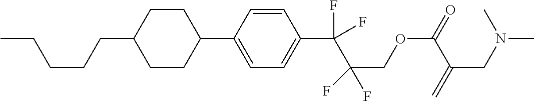 [SMILES: C=C(CN(C)C)C(=O)OCC(F)(F)C(F)(F)c1ccc(C2CCC(CCCCC)CC2)cc1] |
| 1α-6-248 | 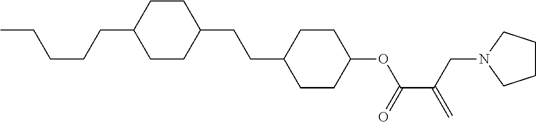 [SMILES: C=C(CN1CCCC1)C(=O)OC1CCC(CCC2CCC(CCCCC)CC2)CC1] |
| 1α-6-249 | 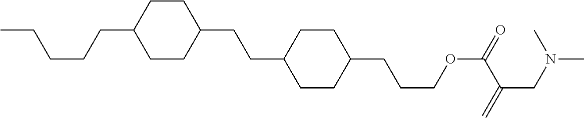 [SMILES: C=C(CN(C)C)C(=O)OCCCC1CCC(CCC2CCC(CCCCC)CC2)CC1] |
| 1α-6-250 | 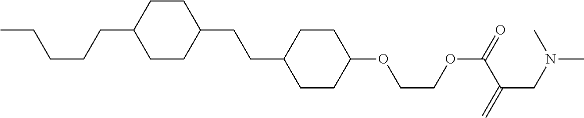 [SMILES: C=C(CN(C)C)C(=O)OCCOC1CCC(CCC2CCC(CCCCC)CC2)CC1] |
| 1α-6-251 | 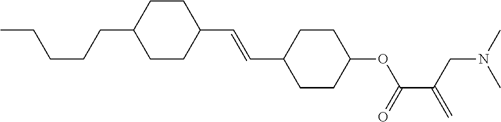 [SMILES: C=C(CN(C)C)C(=O)OC1CCC(/C=C/C2CCC(CCCCC)CC2)CC1] |
| 1α-6-252 | 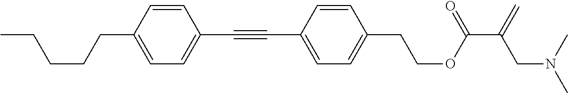 [SMILES: C=C(CN(C)C)C(=O)OCCc1ccc(C#Cc2ccc(CCCCC)cc2)cc1] |
| 1α-6-253 | 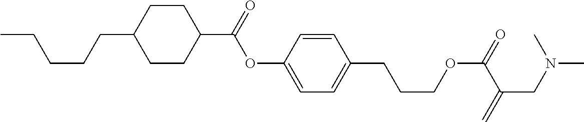 [SMILES: C=C(CN(C)C)C(=O)OCCCc1ccc(OC(=O)C2CCC(CCCCC)CC2)cc1] |
| 1α-6-254 | 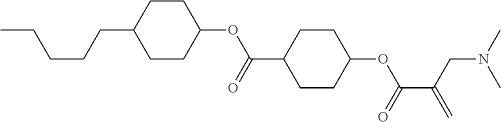 [SMILES: C=C(CN(C)C)C(=O)OC1CCC(C(=O)OC2CCC(CCCCC)CC2)CC1] |
| 1α-6-255 | 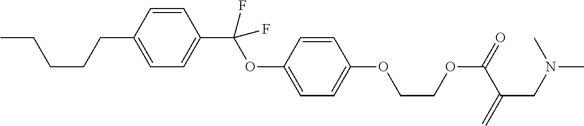 [SMILES: C=C(CN(C)C)C(=O)OCCOc1ccc(OC(F)(F)c2ccc(CCCCC)cc2)cc1] |
| 1α-6-256 | 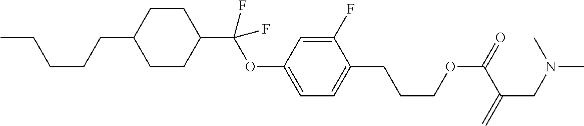 [SMILES: C=C(CN(C)C)C(=O)OCCCc1ccc(OC(F)(F)C2CCC(CCCCC)CC2)cc1F] |
| 1α-6-257 | 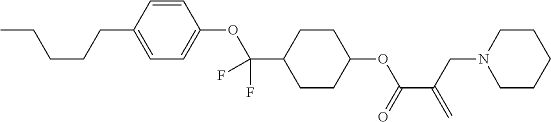 [SMILES: C=C(CN1CCCCC1)C(=O)OC1CCC(C(F)(F)Oc2ccc(CCCCC)cc2)CC1] |
| 1α-6-258 | 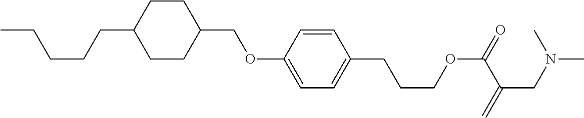 [SMILES: C=C(CN(C)C)C(=O)OCCCc1ccc(OCC2CCC(CCCCC)CC2)cc1] |
| 1α-6-259 | 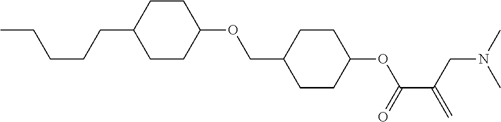 [SMILES: C=C(CN(C)C)C(=O)OC1CCC(COC2CCC(CCCCC)CC2)CC1] |
| 1α-6-260 | 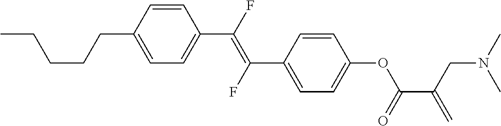 [SMILES: C=C(CN(C)C)C(=O)Oc1ccc(/C(F)=C(\F)c2ccc(CCCCC)cc2)cc1] |

### 15. Example of Compound (1β)

According to the synthesis methods described in Synthesis Examples, compounds (1β-3-1) to (1β-3-82), compounds (1β-4-1) to (1β-4-244), compounds (1β-5-1) to (1β-5-296) and compounds (1β-6-1) to (1β-6-258) shown below can be prepared.

No.

| | |
|---|---|
| 1β-3-1 | 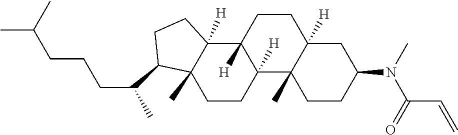 |
| 1β-3-2 | 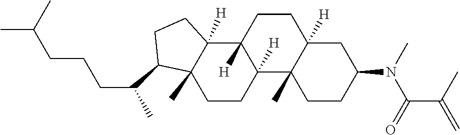 |
| 1β-3-3 | 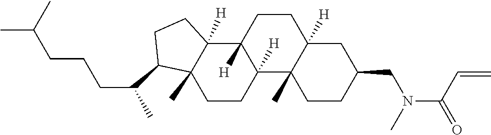 |
| 1β-3-4 | 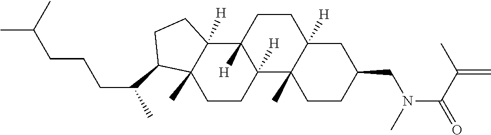 |
| 1β-3-5 | 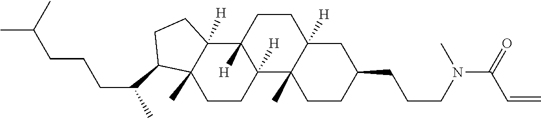 |
| 1β-3-6 | 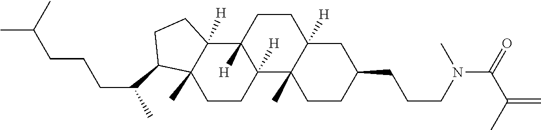 |
| 1β-3-7 | 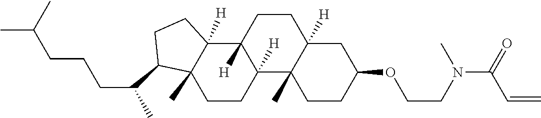 |
| 1β-3-8 | 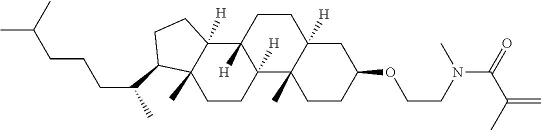 |
| 1β-3-9 | 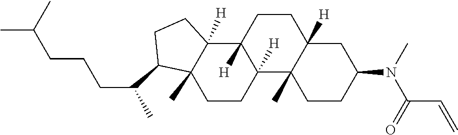 |
| 1β-3-10 | 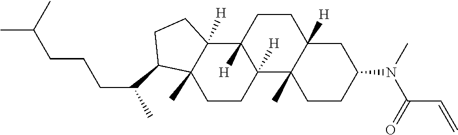 |
| 1β-3-11 | 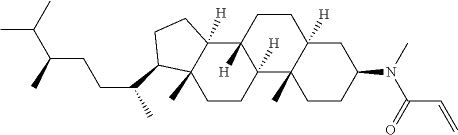 |
| 1β-3-12 | 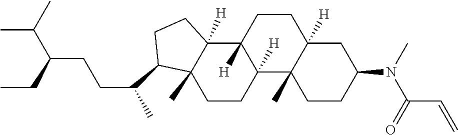 |
| 1β-3-13 | 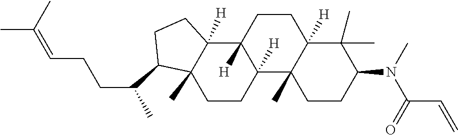 |
| 1β-3-14 | 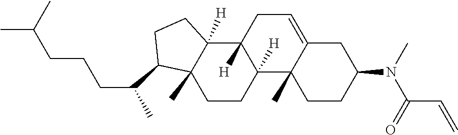 |
| 1β-3-15 | 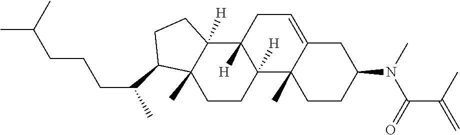 |
| 1β-3-16 | 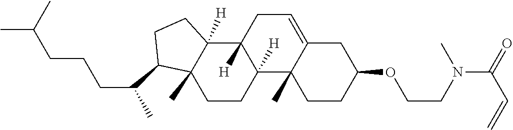 |
| 1β-3-17 | 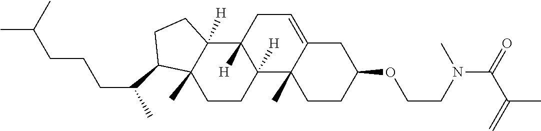 |
| 1β-3-18 | 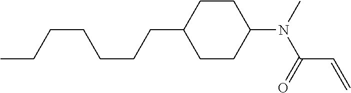 [SMILES: C=CC(=O)N(C)C1CCC(CCCCCCC)CC1] |
| 1β-3-19 | 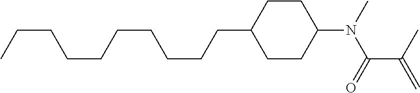 [SMILES: C=C(C)C(=O)N(C)C1CCC(CCCCCCCCCC)CC1] |
| 1β-3-20 | 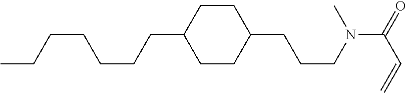 [SMILES: C=CC(=O)N(C)CCCC1CCC(CCCCCCC)CC1] |
| 1β-3-21 | 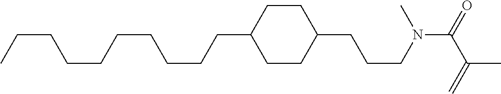 [SMILES: C=C(C)C(=O)N(C)CCCC1CCC(CCCCCCCCCC)CC1] |
| 1β-3-22 | 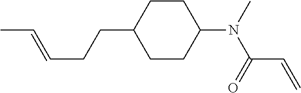 [SMILES: C=CC(=O)N(C)C1CCC(CC/C=C/C)CC1] |
| 1β-3-23 | 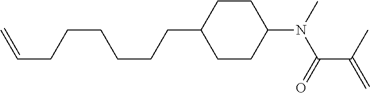 [SMILES: C=CCCCCCCC1CCC(N(C)C(=O)C(=C)C)CC1] |
| 1β-3-24 | 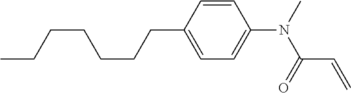 [SMILES: C=CC(=O)N(C)c1ccc(CCCCCCC)cc1] |
| 1β-3-25 | 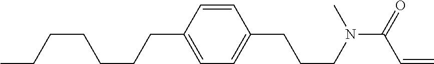 [SMILES: C=CC(=O)N(C)CCCc1ccc(CCCCCCC)cc1] |
| 1β-3-26 | 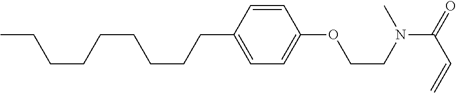 [SMILES: C=CC(=O)N(C)CCOc1ccc(CCCCCCCCC)cc1] |
| 1β-3-27 | 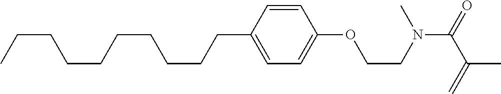 [SMILES: C=C(C)C(=O)N(C)CCOc1ccc(CCCCCCCCCC)cc1] |
| 1β-3-28 | 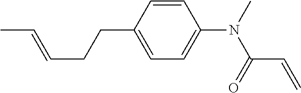 [SMILES: C=CC(=O)N(C)c1ccc(CC/C=C/C)cc1] |
| 1β-3-29 | 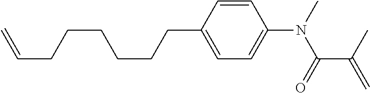 [SMILES: C=CCCCCCCc1ccc(N(C)C(=O)C(=C)C)cc1] |
| 1β-3-30 | 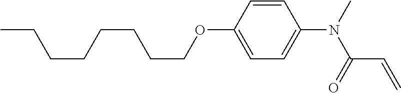 [SMILES: C=CC(=O)N(C)c1ccc(OCCCCCCCC)cc1] |
| 1β-3-31 | 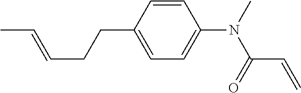 [SMILES: C=CC(=O)N(C)c1ccc(CC/C=C/C)cc1] |
| 1β-3-32 | 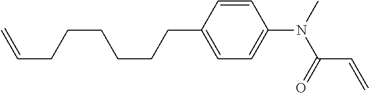 [SMILES: C=CCCCCCCc1ccc(N(C)C(=O)C=C)cc1] |
| 1β-3-33 | 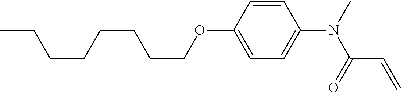 [SMILES: C=CC(=O)N(C)c1ccc(OCCCCCCCC)cc1] |
| 1β-3-34 | 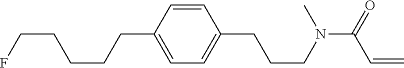 [SMILES: C=CC(=O)N(C)CCCc1ccc(CCCCCF)cc1] |
| 1β-3-35 | 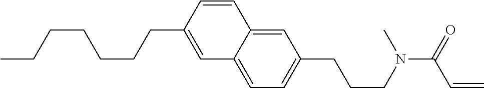 [SMILES: C=CC(=O)N(C)CCCc1ccc2cc(CCCCCCC)ccc2c1] |
| 1β-3-36 | 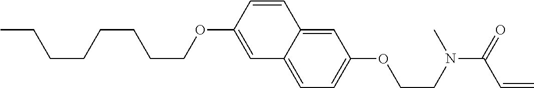 [SMILES: C=CC(=O)N(C)CCOc1ccc2cc(OCCCCCCCC)ccc2c1] |
| 1β-3-37 | 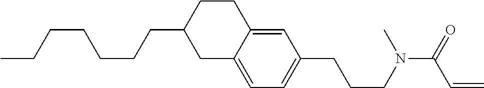 [SMILES: C=CC(=O)N(C)CCCc1ccc2c(c1)CCC(CCCCCCC)C2] |
| 1β-3-38 | 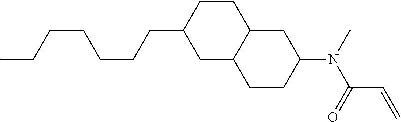 [SMILES: C=CC(=O)N(C)C1CCC2CC(CCCCCCC)CCC2C1] |
| 1β-3-39 | 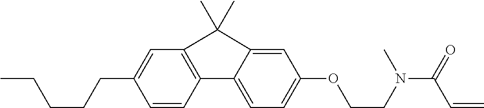 [SMILES: C=CC(=O)N(C)CCOc1ccc2c(c1)C(C)(C)c1cc(CCCCC)ccc1-2] |
| 1β-3-40 | 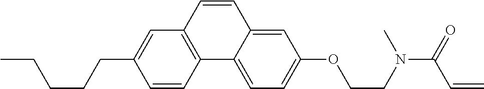 [SMILES: C=CC(=O)N(C)CCOc1ccc2c(ccc3cc(CCCCC)ccc32)c1] |
| 1β-3-41 | 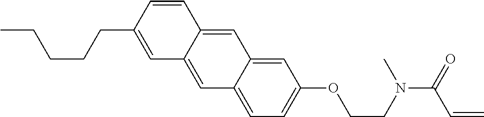 [SMILES: C=CC(=O)N(C)CCOc1ccc2cc3cc(CCCCC)ccc3cc2c1] |
| 1β-3-42 | 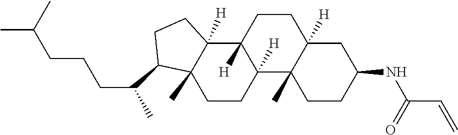 |
| 1β-3-43 | 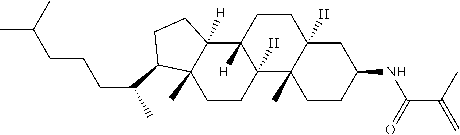 |
| 1β-3-44 | 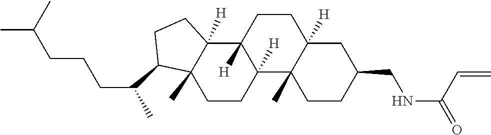 |
| 1β-3-45 | 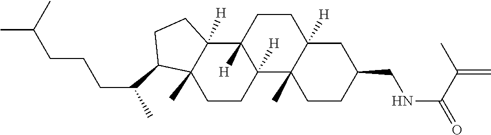 |
| 1β-3-46 | 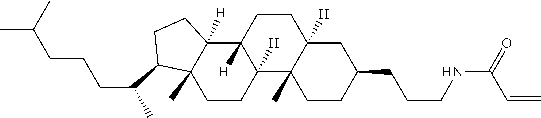 |
| 1β-3-47 | 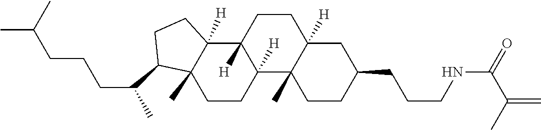 |
| 1β-3-48 | 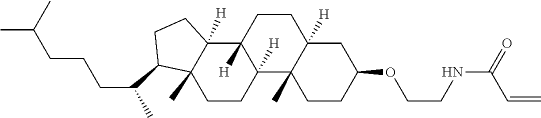 |
| 1β-3-49 | 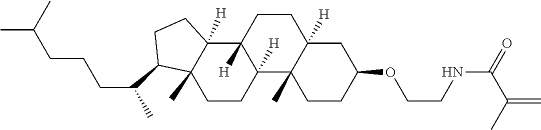 |
| 1β-3-50 | 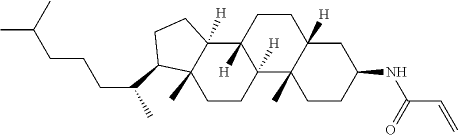 |
| 1β-3-51 | 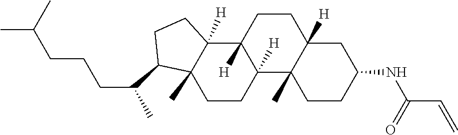 |
| 1β-3-52 | 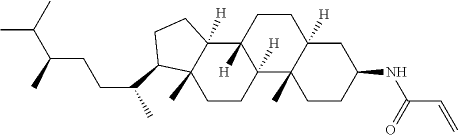 |
| 1β-3-53 | 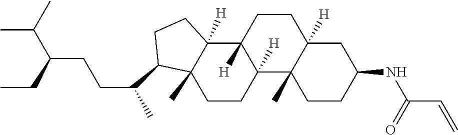 |
| 1β-3-54 | 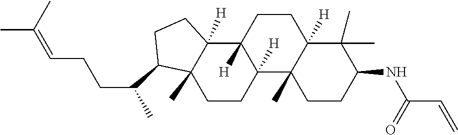 |
| 1β-3-55 | 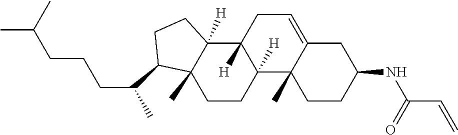 |
| 1β-3-56 | 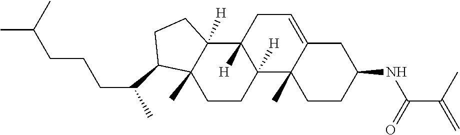 |
| 1β-3-57 | 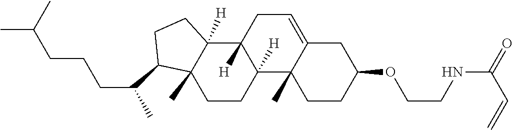 |
| 1β-3-58 | 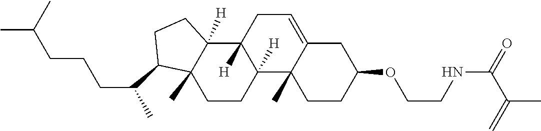 |
| 1β-3-59 | 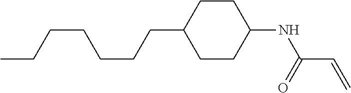 [SMILES: C=CC(=O)NC1CCC(CCCCCCC)CC1] |
| 1β-3-60 | 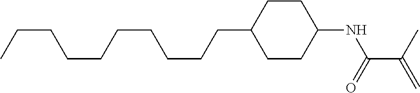 [SMILES: C=C(C)C(=O)NC1CCC(CCCCCCCCCC)CC1] |
| 1β-3-61 | 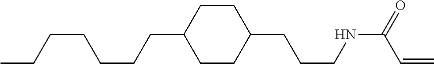 [SMILES: C=CC(=O)NCCCC1CCC(CCCCCCC)CC1] |
| 1β-3-62 | 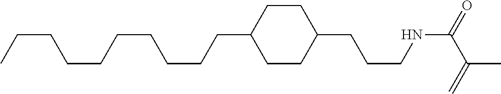 [SMILES: C=C(C)C(=O)NCCCC1CCC(CCCCCCCCCC)CC1] |
| 1β-3-63 | 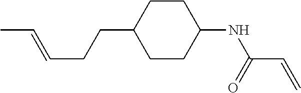 [SMILES: C=CC(=O)NC1CCC(CC/C=C/C)CC1] |
| 1β-3-64 | 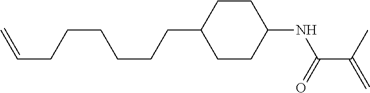 [SMILES: C=CCCCCCCC1CCC(NC(=O)C(=C)C)CC1] |
| 1β-3-65 | 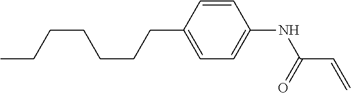 [SMILES: C=CC(=O)Nc1ccc(CCCCCCC)cc1] |
| 1β-3-66 | 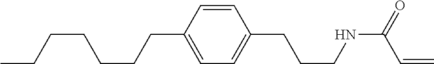 [SMILES: C=CC(=O)NCCCc1ccc(CCCCCCC)cc1] |
| 1β-3-67 | 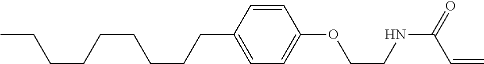 [SMILES: C=CC(=O)NCCOc1ccc(CCCCCCCCC)cc1] |
| 1β-3-68 | 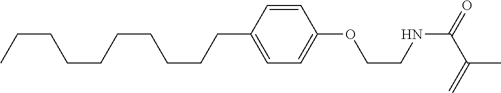 [SMILES: C=C(C)C(=O)NCCOc1ccc(CCCCCCCCCC)cc1] |
| 1β-3-69 | 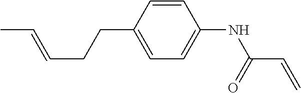 [SMILES: C=CC(=O)Nc1ccc(CC/C=C/C)cc1] |
| 1β-3-70 | 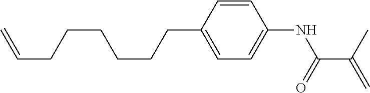 [SMILES: C=CCCCCCCc1ccc(NC(=O)C(=C)C)cc1] |
| 1β-3-71 | 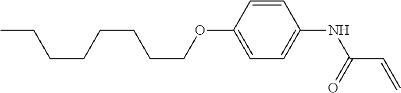 [SMILES: C=CC(=O)Nc1ccc(OCCCCCCCC)cc1] |
| 1β-3-72 | 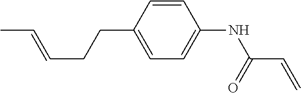 [SMILES: C=CC(=O)Nc1ccc(CC/C=C/C)cc1] |
| 1β-3-73 | 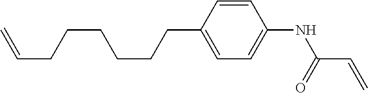 [SMILES: C=CCCCCCCc1ccc(NC(=O)C=C)cc1] |
| 1β-3-74 | 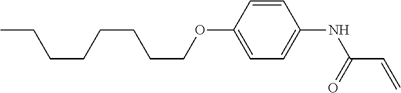 [SMILES: C=CC(=O)Nc1ccc(OCCCCCCCC)cc1] |
| 1β-3-75 | 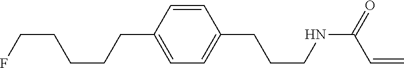 [SMILES: C=CC(=O)NCCCc1ccc(CCCCCF)cc1] |
| 1β-3-76 | 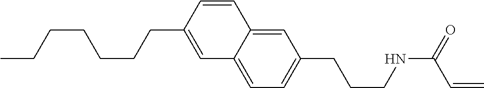 [SMILES: C=CC(=O)NCCCc1ccc2cc(CCCCCCC)ccc2c1] |
| 1β-3-77 | 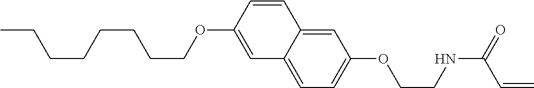 [SMILES: C=CC(=O)NCCOc1ccc2cc(OCCCCCCCC)ccc2c1] |
| 1β-3-78 | 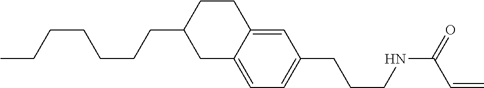 [SMILES: C=CC(=O)NCCCc1ccc2c(c1)CCC(CCCCCCC)C2] |
| 1β-3-79 | 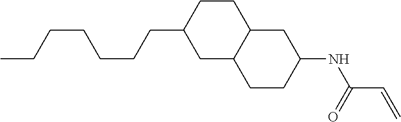 [SMILES: C=CC(=O)NC1CCC2CC(CCCCCCC)CCC2C1] |
| 1β-3-80 | 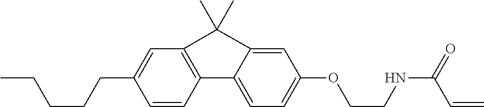 [SMILES: C=CC(=O)NCCOc1ccc2c(c1)C(C)(C)c1cc(CCCCC)ccc1-2] |
| 1β-3-81 | 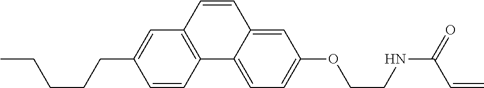 [SMILES: C=CC(=O)NCCOc1ccc2c(ccc3cc(CCCCC)ccc32)c1] |
| 1β-3-82 | 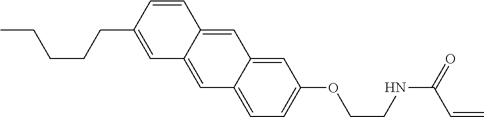 [SMILES: C=CC(=O)NCCOc1ccc2cc3cc(CCCCC)ccc3cc2c1] |
| 1β-4-1 | 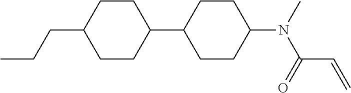 [SMILES: C=CC(=O)N(C)C1CCC(C2CCC(CCC)CC2)CC1] |
| 1β-4-2 | 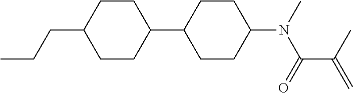 [SMILES: C=C(C)C(=O)N(C)C1CCC(C2CCC(CCC)CC2)CC1] |
| 1β-4-3 | 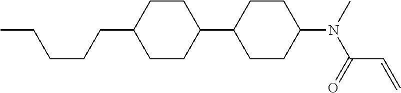 [SMILES: C=CC(=O)N(C)C1CCC(C2CCC(CCCCC)CC2)CC1] |
| 1β-4-4 | 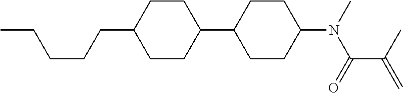 [SMILES: C=C(C)C(=O)N(C)C1CCC(C2CCC(CCCCC)CC2)CC1] |
| 1β-4-5 | 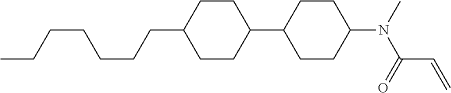 [SMILES: C=CC(=O)N(C)C1CCC(C2CCC(CCCCCCC)CC2)CC1] |
| 1β-4-6 | 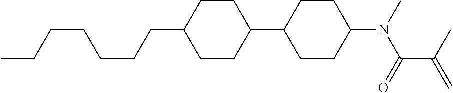 [SMILES: C=C(C)C(=O)N(C)C1CCC(C2CCC(CCCCCCC)CC2)CC1] |
| 1β-4-7 | 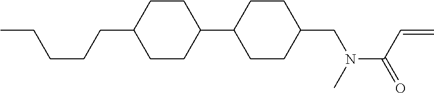 [SMILES: C=CC(=O)N(C)CC1CCC(C2CCC(CCCCC)CC2)CC1] |
| 1β-4-8 | 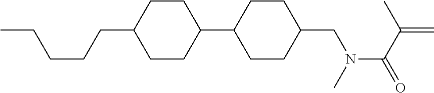 [SMILES: C=C(C)C(=O)N(C)CC1CCC(C2CCC(CCCCC)CC2)CC1] |
| 1β-4-9 | 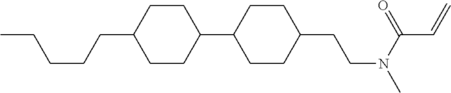 [SMILES: C=CC(=O)N(C)CCC1CCC(C2CCC(CCCCC)CC2)CC1] |
| 1β-4-10 | 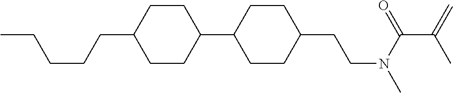 [SMILES: C=C(C)C(=O)N(C)CCC1CCC(C2CCC(CCCCC)CC2)CC1] |
| 1β-4-11 | 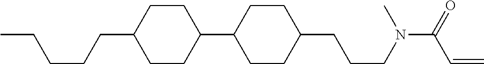 [SMILES: C=CC(=O)N(C)CCCC1CCC(C2CCC(CCCCC)CC2)CC1] |
| 1β-4-12 | 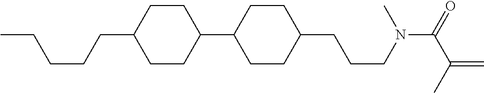 [SMILES: C=C(C)C(=O)N(C)CCCC1CCC(C2CCC(CCCCC)CC2)CC1] |
| 1β-4-13 | 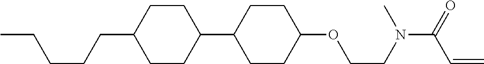 [SMILES: C=CC(=O)N(C)CCOC1CCC(C2CCC(CCCCC)CC2)CC1] |
| 1β-4-14 | 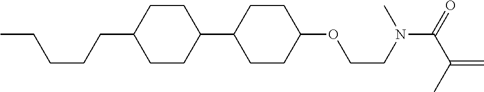 [SMILES: C=C(C)C(=O)N(C)CCOC1CCC(C2CCC(CCCCC)CC2)CC1] |
| 1β-4-15 | 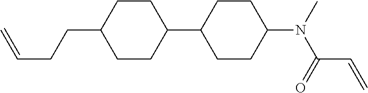 [SMILES: C=CCCC1CCC(C2CCC(N(C)C(=O)C=C)CC2)CC1] |
| 1β-4-16 | 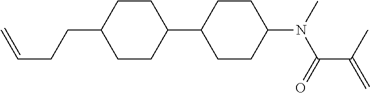 [SMILES: C=CCCC1CCC(C2CCC(N(C)C(=O)C(=C)C)CC2)CC1] |
| 1β-4-17 | 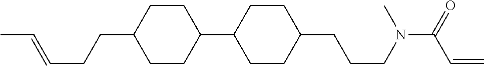 [SMILES: C=CC(=O)N(C)CCCC1CCC(C2CCC(CC/C=C/C)CC2)CC1] |
| 1β-4-18 | 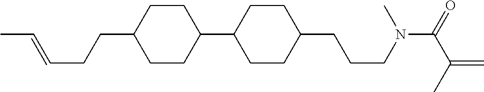 [SMILES: C=C(C)C(=O)N(C)CCCC1CCC(C2CCC(CC/C=C/C)CC2)CC1] |
| 1β-4-19 | 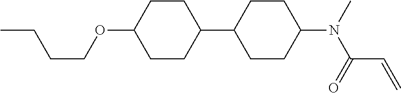 [SMILES: C=CC(=O)N(C)C1CCC(C2CCC(OCCCC)CC2)CC1] |
| 1β-4-20 | 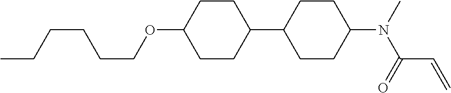 [SMILES: C=CC(=O)N(C)C1CCC(C2CCC(OCCCCCC)CC2)CC1] |
| 1β-4-21 | 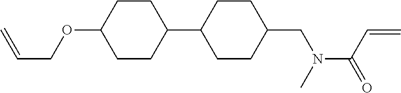 [SMILES: C=CCOC1CCC(C2CCC(CN(C)C(=O)C=C)CC2)CC1] |
| 1β-4-22 | 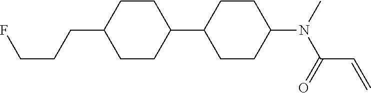 [SMILES: C=CC(=O)N(C)C1CCC(C2CCC(CCCF)CC2)CC1] |
| 1β-4-23 | 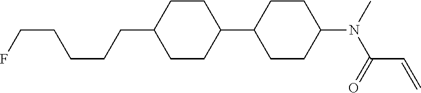 [SMILES: C=CC(=O)N(C)C1CCC(C2CCC(CCCCCF)CC2)CC1] |
| 1β-4-24 | 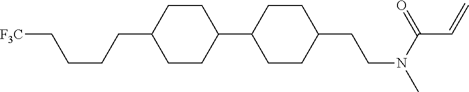 [SMILES: C=CC(=O)N(C)CCC1CCC(C2CCC(CCCCC(F)(F)F)CC2)CC1] |
| 1β-4-25 | 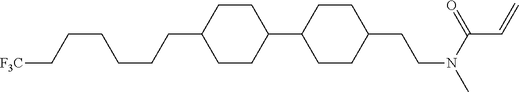 [SMILES: C=CC(=O)N(C)CCC1CCC(C2CCC(CCCCCCC(F)(F)F)CC2)CC1] |
| 1β-4-26 | 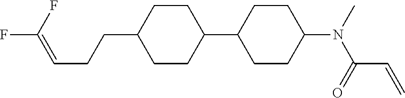 [SMILES: C=CC(=O)N(C)C1CCC(C2CCC(CCC=C(F)F)CC2)CC1] |
| 1β-4-27 | 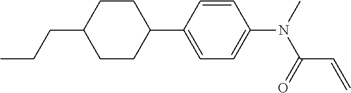 [SMILES: C=CC(=O)N(C)c1ccc(C2CCC(CCC)CC2)cc1] |
| 1β-4-28 | 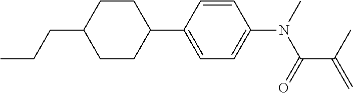 [SMILES: C=C(C)C(=O)N(C)c1ccc(C2CCC(CCC)CC2)cc1] |
| 1β-4-29 | 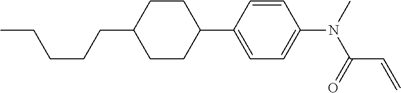 [SMILES: C=CC(=O)N(C)c1ccc(C2CCC(CCCCC)CC2)cc1] |
| 1β-4-30 | 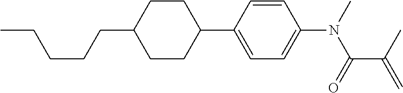 [SMILES: C=C(C)C(=O)N(C)c1ccc(C2CCC(CCCCC)CC2)cc1] |
| 1β-4-31 | 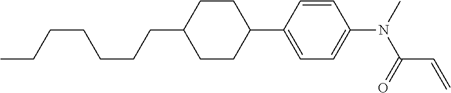 [SMILES: C=CC(=O)N(C)c1ccc(C2CCC(CCCCCCC)CC2)cc1] |
| 1β-4-32 | 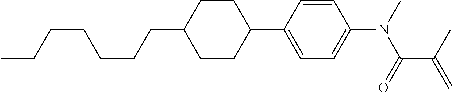 [SMILES: C=C(C)C(=O)N(C)c1ccc(C2CCC(CCCCCCC)CC2)cc1] |
| 1β-4-33 | 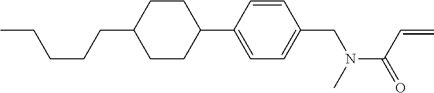 [SMILES: C=CC(=O)N(C)Cc1ccc(C2CCC(CCCCC)CC2)cc1] |
| 1β-4-34 | 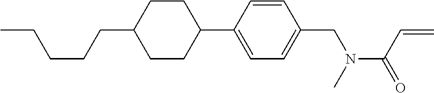 [SMILES: C=CC(=O)N(C)Cc1ccc(C2CCC(CCCCC)CC2)cc1] |
| 1β-4-35 | 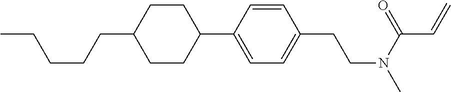 [SMILES: C=CC(=O)N(C)CCc1ccc(C2CCC(CCCCC)CC2)cc1] |
| 1β-4-36 | 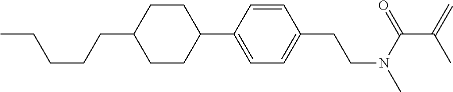 [SMILES: C=C(C)C(=O)N(C)CCc1ccc(C2CCC(CCCCC)CC2)cc1] |
| 1β-4-37 | 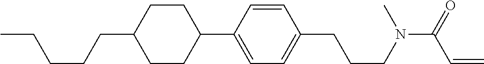 [SMILES: C=CC(=O)N(C)CCCc1ccc(C2CCC(CCCCC)CC2)cc1] |
| 1β-4-38 | 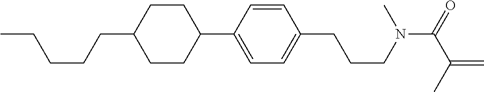 [SMILES: C=C(C)C(=O)N(C)CCCc1ccc(C2CCC(CCCCC)CC2)cc1] |
| 1β-4-39 | 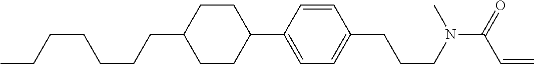 [SMILES: C=CC(=O)N(C)CCCc1ccc(C2CCC(CCCCCCC)CC2)cc1] |
| 1β-4-40 | 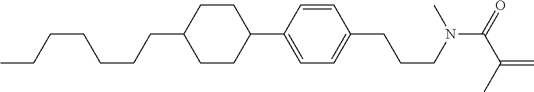 [SMILES: C=C(C)C(=O)N(C)CCCc1ccc(C2CCC(CCCCCCC)CC2)cc1] |
| 1β-4-41 | 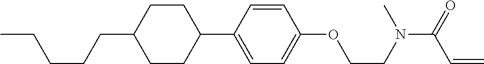 [SMILES: C=CC(=O)N(C)CCOc1ccc(C2CCC(CCCCC)CC2)cc1] |
| 1β-4-42 | 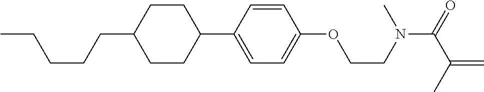 [SMILES: C=C(C)C(=O)N(C)CCOc1ccc(C2CCC(CCCCC)CC2)cc1] |
| 1β-4-43 | 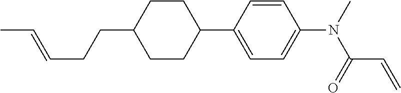 [SMILES: C=CC(=O)N(C)c1ccc(C2CCC(CC/C=C/C)CC2)cc1] |
| 1β-4-44 | 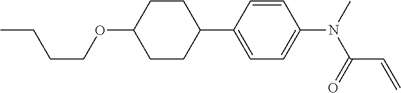 [SMILES: C=CC(=O)N(C)c1ccc(C2CCC(OCCCC)CC2)cc1] |
| 1β-4-45 | 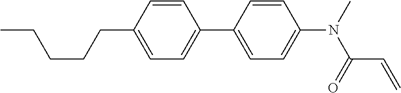 [SMILES: C=CC(=O)N(C)c1ccc(-c2ccc(CCCCC)cc2)cc1] |
| 1β-4-46 | 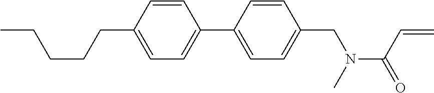 [SMILES: C=CC(=O)N(C)Cc1ccc(-c2ccc(CCCCC)cc2)cc1] |
| 1β-4-47 | 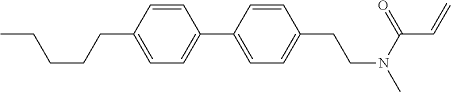 [SMILES: C=CC(=O)N(C)CCc1ccc(-c2ccc(CCCCC)cc2)cc1] |
| 1β-4-48 | 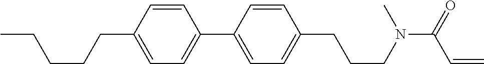 [SMILES: C=CC(=O)N(C)CCCc1ccc(-c2ccc(CCCCC)cc2)cc1] |
| 1β-4-49 | 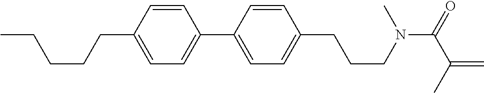 [SMILES: C=C(C)C(=O)N(C)CCCc1ccc(-c2ccc(CCCCC)cc2)cc1] |
| 1β-4-50 | 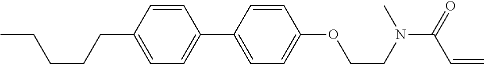 [SMILES: C=CC(=O)N(C)CCOc1ccc(-c2ccc(CCCCC)cc2)cc1] |
| 1β-4-51 | 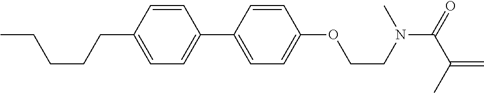 [SMILES: C=C(C)C(=O)N(C)CCOc1ccc(-c2ccc(CCCCC)cc2)cc1] |
| 1β-4-52 | 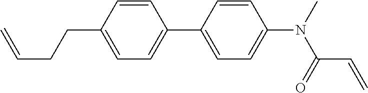 [SMILES: C=CCCc1ccc(-c2ccc(N(C)C(=O)C=C)cc2)cc1] |
| 1β-4-53 | 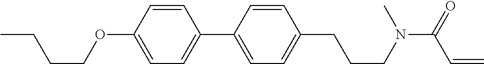 [SMILES: C=CC(=O)N(C)CCCc1ccc(-c2ccc(OCCCC)cc2)cc1] |
| 1β-4-54 | 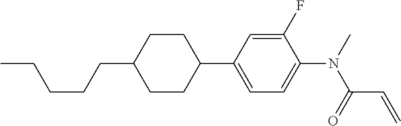 [SMILES: C=CC(=O)N(C)c1ccc(C2CCC(CCCCC)CC2)cc1F] |
| 1β-4-55 | 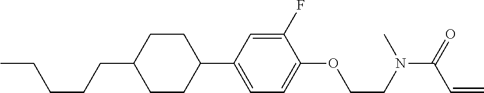 [SMILES: C=CC(=O)N(C)CCOc1ccc(C2CCC(CCCCC)CC2)cc1F] |
| 1β-4-56 | 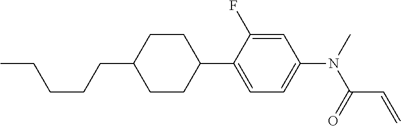 [SMILES: C=CC(=O)N(C)c1ccc(C2CCC(CCCCC)CC2)c(F)c1] |
| 1β-4-57 | 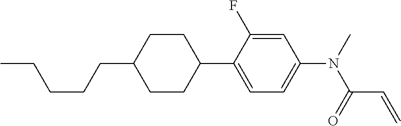 [SMILES: C=CC(=O)N(C)c1ccc(C2CCC(CCCCC)CC2)c(F)c1] |
| 1β-4-58 | 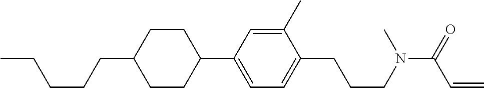 [SMILES: C=CC(=O)N(C)CCCc1ccc(C2CCC(CCCCC)CC2)cc1C] |
| 1β-4-59 | 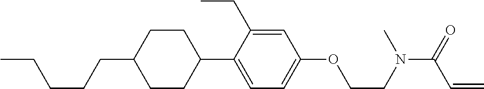 [SMILES: C=CC(=O)N(C)CCOc1ccc(C2CCC(CCCCC)CC2)c(CC)c1] |
| 1β-4-60 | 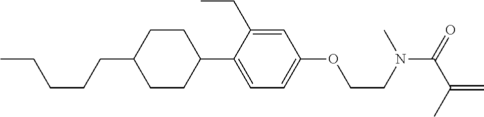 [SMILES: C=C(C)C(=O)N(C)CCOc1ccc(C2CCC(CCCCC)CC2)c(CC)c1] |
| 1β-4-61 | 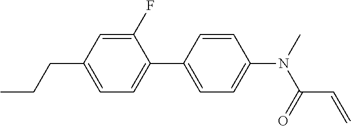 [SMILES: C=CC(=O)N(C)c1ccc(-c2ccc(CCC)cc2F)cc1] |
| 1β-4-62 | 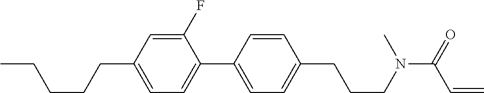 [SMILES: C=CC(=O)N(C)CCCc1ccc(-c2ccc(CCCCC)cc2F)cc1] |
| 1β-4-63 | 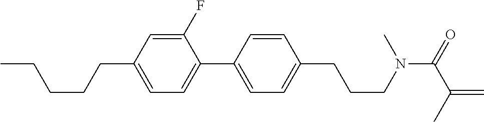 [SMILES: C=C(C)C(=O)N(C)CCCc1ccc(-c2ccc(CCCCC)cc2F)cc1] |
| 1β-4-64 | 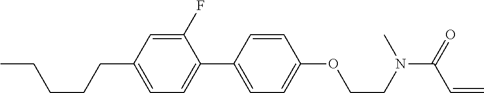 [SMILES: C=CC(=O)N(C)CCOc1ccc(-c2ccc(CCCCC)cc2F)cc1] |
| 1β-4-65 | 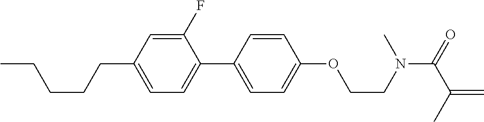 [SMILES: C=C(C)C(=O)N(C)CCOc1ccc(-c2ccc(CCCCC)cc2F)cc1] |
| 1β-4-66 | 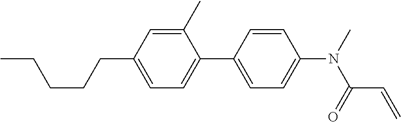 [SMILES: C=CC(=O)N(C)c1ccc(-c2ccc(CCCCC)cc2C)cc1] |
| 1β-4-67 | 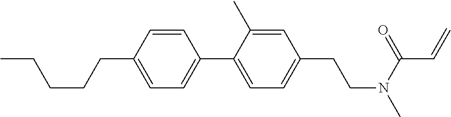 [SMILES: C=CC(=O)N(C)CCc1ccc(-c2ccc(CCCCC)cc2)c(C)c1] |
| 1β-4-68 | 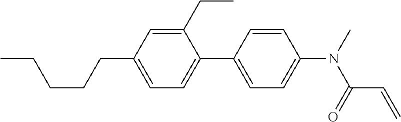 [SMILES: C=CC(=O)N(C)c1ccc(-c2ccc(CCCCC)cc2CC)cc1] |
| 1β-4-69 | 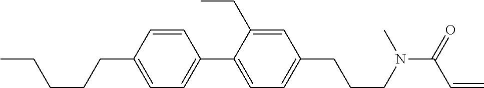 [SMILES: C=CC(=O)N(C)CCCc1ccc(-c2ccc(CCCCC)cc2)c(CC)c1] |
| 1β-4-70 | 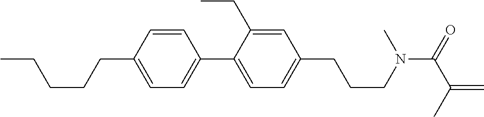 [SMILES: C=C(C)C(=O)N(C)CCCc1ccc(-c2ccc(CCCCC)cc2)c(CC)c1] |
| 1β-4-71 | 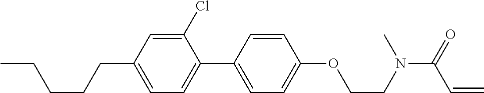 [SMILES: C=CC(=O)N(C)CCOc1ccc(-c2ccc(CCCCC)cc2Cl)cc1] |
| 1β-4-72 | 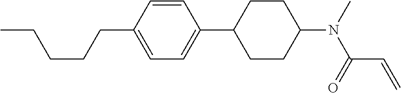 [SMILES: C=CC(=O)N(C)C1CCC(c2ccc(CCCCC)cc2)CC1] |
| 1β-4-73 | 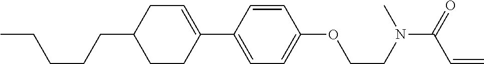 [SMILES: C=CC(=O)N(C)CCOc1ccc(C2=CCC(CCCCC)CC2)cc1] |
| 1β-4-74 | 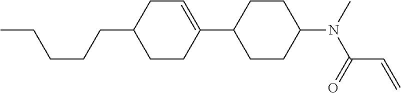 [SMILES: C=CC(=O)N(C)C1CCC(C2=CCC(CCCCC)CC2)CC1] |
| 1β-4-75 | 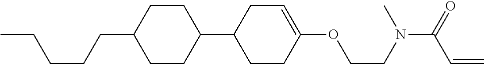 [SMILES: C=CC(=O)N(C)CCOC1=CCC(C2CCC(CCCCC)CC2)CC1] |
| 1β-4-76 | 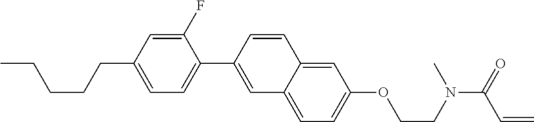 [SMILES: C=CC(=O)N(C)CCOc1ccc2cc(-c3ccc(CCCCC)cc3F)ccc2c1] |
| 1β-4-77 | 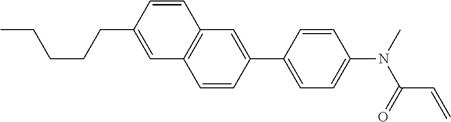 [SMILES: C=CC(=O)N(C)c1ccc(-c2ccc3cc(CCCCC)ccc3c2)cc1] |
| 1β-4-78 | 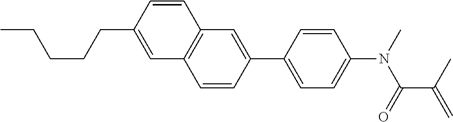 [SMILES: C=C(C)C(=O)N(C)c1ccc(-c2ccc3cc(CCCCC)ccc3c2)cc1] |
| 1β-4-79 | 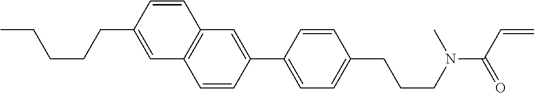 [SMILES: C=CC(=O)N(C)CCCc1ccc(-c2ccc3cc(CCCCC)ccc3c2)cc1] |
| 1β-4-80 | 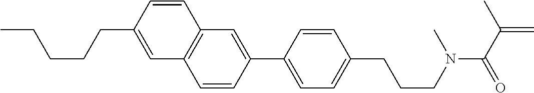 [SMILES: C=C(C)C(=O)N(C)CCCc1ccc(-c2ccc3cc(CCCCC)ccc3c2)cc1] |
| 1β-4-81 | 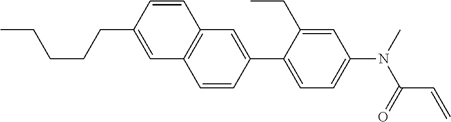 [SMILES: C=CC(=O)N(C)c1ccc(-c2ccc3cc(CCCCC)ccc3c2)c(CC)c1] |
| 1β-4-82 | 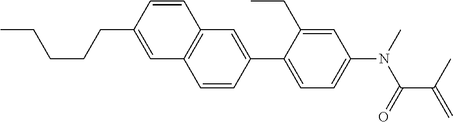 [SMILES: C=C(C)C(=O)N(C)c1ccc(-c2ccc3cc(CCCCC)ccc3c2)c(CC)c1] |
| 1β-4-83 | 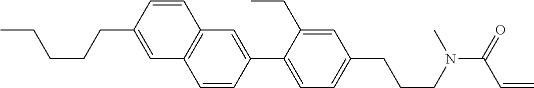 [SMILES: C=CC(=O)N(C)CCCc1ccc(-c2ccc3cc(CCCCC)ccc3c2)c(CC)c1] |
| 1β-4-84 | 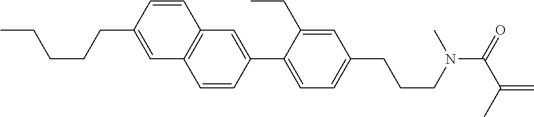 [SMILES: C=C(C)C(=O)N(C)CCCc1ccc(-c2ccc3cc(CCCCC)ccc3c2)c(CC)c1] |
| 1β-4-85 | 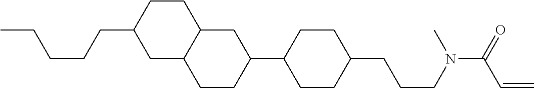 [SMILES: C=CC(=O)N(C)CCCC1CCC(C2CCC3CC(CCCCC)CCC3C2)CC1] |
| 1β-4-86 | 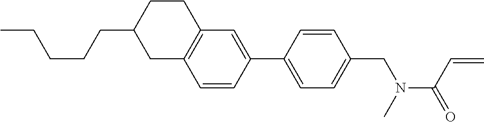 [SMILES: C=CC(=O)N(C)Cc1ccc(-c2ccc3c(c2)CCC(CCCCC)C3)cc1] |
| 1β-4-87 | 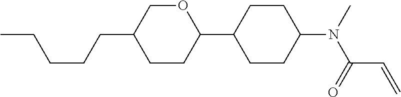 [SMILES: C=CC(=O)N(C)C1CCC(C2CCC(CCCCC)CO2)CC1] |
| 1β-4-88 | 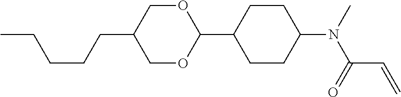 [SMILES: C=CC(=O)N(C)C1CCC(C2OCC(CCCCC)CO2)CC1] |
| 1β-4-89 | 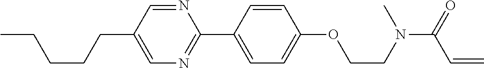 [SMILES: C=CC(=O)N(C)CCOc1ccc(-c2ncc(CCCCC)cn2)cc1] |
| 1β-4-90 | 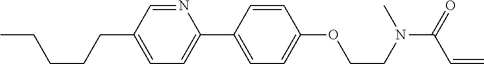 [SMILES: C=CC(=O)N(C)CCOc1ccc(-c2ccc(CCCCC)cn2)cc1] |
| 1β-4-91 | 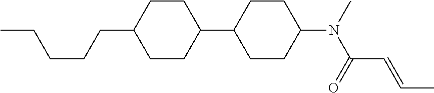 [SMILES: C/C=C/C(=O)N(C)C1CCC(C2CCC(CCCCC)CC2)CC1] |
| 1β-4-92 | 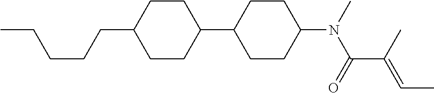 [SMILES: C/C=C(\C)C(=O)N(C)C1CCC(C2CCC(CCCCC)CC2)CC1] |
| 1β-4-93 | 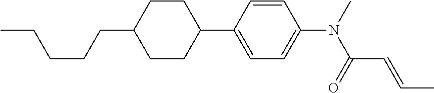 [SMILES: C/C=C/C(=O)N(C)c1ccc(C2CCC(CCCCC)CC2)cc1] |
| 1β-4-94 | 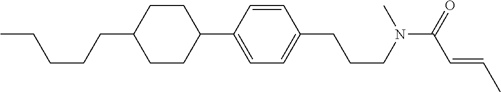 [SMILES: C/C=C/C(=O)N(C)CCCc1ccc(C2CCC(CCCCC)CC2)cc1] |
| 1β-4-95 | 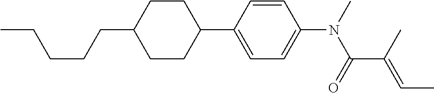 [SMILES: C/C=C(\C)C(=O)N(C)c1ccc(C2CCC(CCCCC)CC2)cc1] |
| 1β-4-96 | 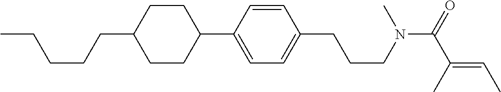 [SMILES: C/C=C(\C)C(=O)N(C)CCCc1ccc(C2CCC(CCCCC)CC2)cc1] |
| 1β-4-97 | 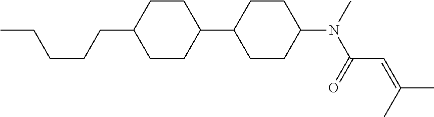 [SMILES: CCCCCC1CCC(C2CCC(N(C)C(=O)C=C(C)C)CC2)CC1] |
| 1β-4-98 | 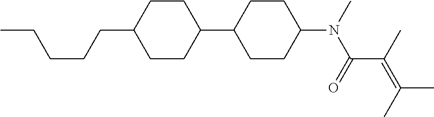 [SMILES: CCCCCC1CCC(C2CCC(N(C)C(=O)C(C)=C(C)C)CC2)CC1] |
| 1β-4-99 | 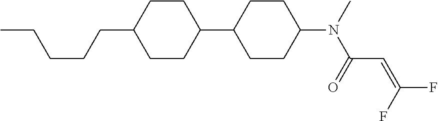 [SMILES: CCCCCC1CCC(C2CCC(N(C)C(=O)C=C(F)F)CC2)CC1] |
| 1β-4-100 | 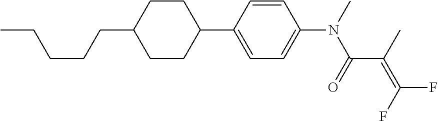 [SMILES: CCCCCC1CCC(c2ccc(N(C)C(=O)C(C)=C(F)F)cc2)CC1] |
| 1β-4-101 | 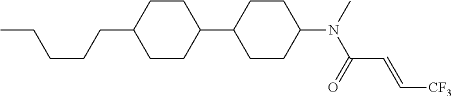 [SMILES: CCCCCC1CCC(C2CCC(N(C)C(=O)/C=C/C(F)(F)F)CC2)CC1] |
| 1β-4-102 | 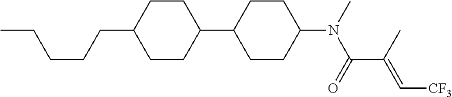 [SMILES: CCCCCC1CCC(C2CCC(N(C)C(=O)/C(C)=C/C(F)(F)F)CC2)CC1] |
| 1β-4-103 | 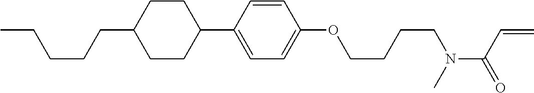 [SMILES: C=CC(=O)N(C)CCCCOc1ccc(C2CCC(CCCCC)CC2)cc1] |
| 1β-4-104 | 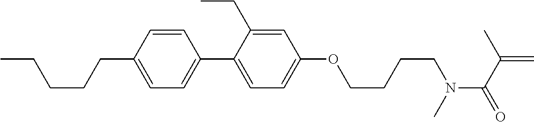 [SMILES: C=C(C)C(=O)N(C)CCCCOc1ccc(-c2ccc(CCCCC)cc2)c(CC)c1] |
| 1β-4-105 | 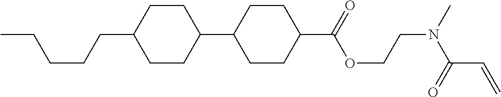 [SMILES: C=CC(=O)N(C)CCOC(=O)C1CCC(C2CCC(CCCCC)CC2)CC1] |
| 1β-4-106 | 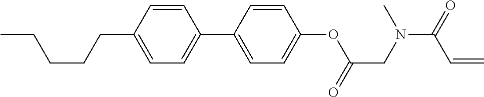 [SMILES: C=CC(=O)N(C)CC(=O)Oc1ccc(-c2ccc(CCCCC)cc2)cc1] |
| 1β-4-107 | 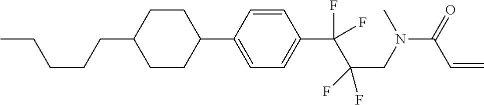 [SMILES: C=CC(=O)N(C)CC(F)(F)C(F)(F)c1ccc(C2CCC(CCCCC)CC2)cc1] |
| 1β-4-108 | 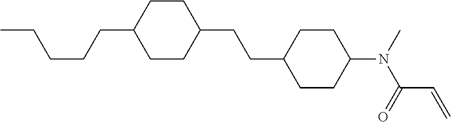 [SMILES: C=CC(=O)N(C)C1CCC(CCC2CCC(CCCCC)CC2)CC1] |
| 1β-4-109 | 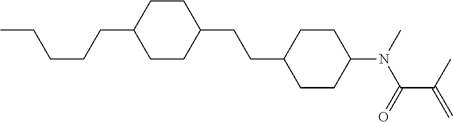 [SMILES: C=C(C)C(=O)N(C)C1CCC(CCC2CCC(CCCCC)CC2)CC1] |
| 1β-4-110 | 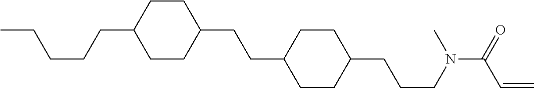 [SMILES: C=CC(=O)N(C)CCCC1CCC(CCC2CCC(CCCCC)CC2)CC1] |
| 1β-4-111 | 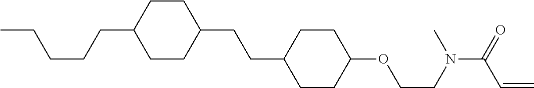 [SMILES: C=CC(=O)N(C)CCOC1CCC(CCC2CCC(CCCCC)CC2)CC1] |
| 1β-4-112 | 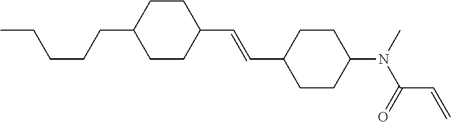 [SMILES: C=CC(=O)N(C)C1CCC(/C=C/C2CCC(CCCCC)CC2)CC1] |
| 1β-4-113 | 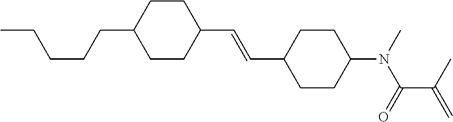 [SMILES: C=C(C)C(=O)N(C)C1CCC(/C=C/C2CCC(CCCCC)CC2)CC1] |
| 1β-4-114 | 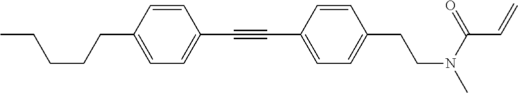 [SMILES: C=CC(=O)N(C)CCc1ccc(C#Cc2ccc(CCCCC)cc2)cc1] |
| 1β-4-115 | 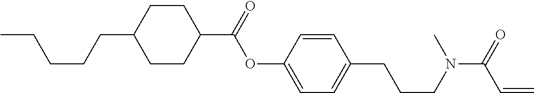 [SMILES: C=CC(=O)N(C)CCCc1ccc(OC(=O)C2CCC(CCCCC)CC2)cc1] |
| 1β-4-116 | 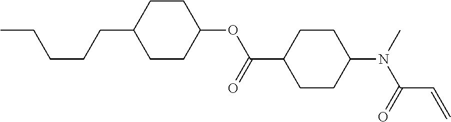 [SMILES: C=CC(=O)N(C)C1CCC(C(=O)OC2CCC(CCCCC)CC2)CC1] |
| 1β-4-117 | 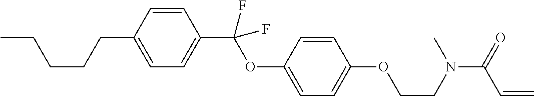 [SMILES: C=CC(=O)N(C)CCOc1ccc(OC(F)(F)c2ccc(CCCCC)cc2)cc1] |
| 1β-4-118 | 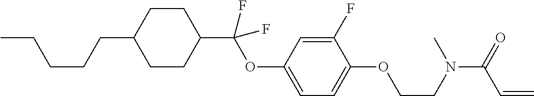 [SMILES: C=CC(=O)N(C)CCOc1ccc(OC(F)(F)C2CCC(CCCCC)CC2)cc1F] |
| 1β-4-119 | 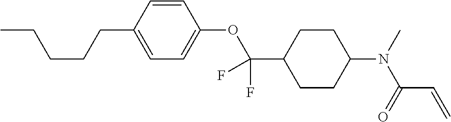 [SMILES: C=CC(=O)N(C)C1CCC(C(F)(F)Oc2ccc(CCCCC)cc2)CC1] |
| 1β-4-120 | 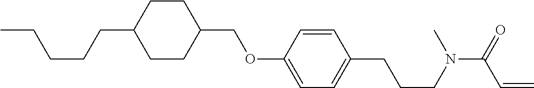 [SMILES: C=CC(=O)N(C)CCCc1ccc(OCC2CCC(CCCCC)CC2)cc1] |
| 1β-4-121 | 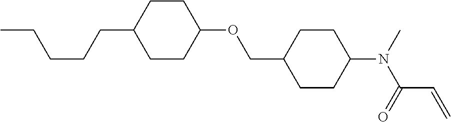 [SMILES: C=CC(=O)N(C)C1CCC(COC2CCC(CCCCC)CC2)CC1] |
| 1β-4-122 | 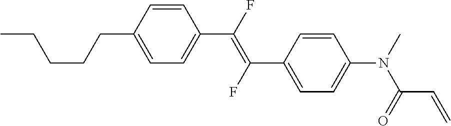 [SMILES: C=CC(=O)N(C)c1ccc(/C(F)=C(\F)c2ccc(CCCCC)cc2)cc1] |
| 1β-4-123 | 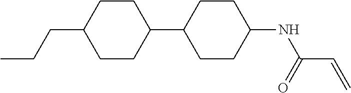 [SMILES: C=CC(=O)NC1CCC(C2CCC(CCC)CC2)CC1] |
| 1β-4-124 | 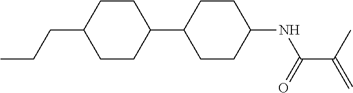 [SMILES: C=C(C)C(=O)NC1CCC(C2CCC(CCC)CC2)CC1] |
| 1β-4-125 | 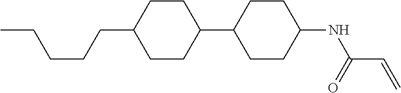 [SMILES: C=CC(=O)NC1CCC(C2CCC(CCCCC)CC2)CC1] |
| 1β-4-126 | 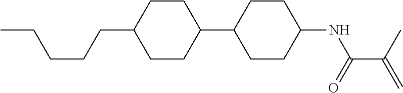 [SMILES: C=C(C)C(=O)NC1CCC(C2CCC(CCCCC)CC2)CC1] |
| 1β-4-127 | 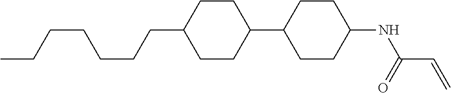 [SMILES: C=CC(=O)NC1CCC(C2CCC(CCCCCCC)CC2)CC1] |
| 1β-4-128 | 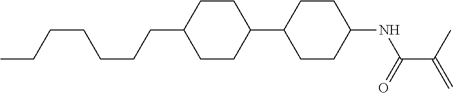 [SMILES: C=C(C)C(=O)NC1CCC(C2CCC(CCCCCCC)CC2)CC1] |
| 1β-4-129 | 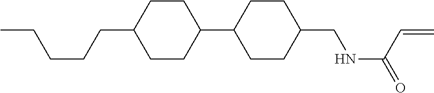 [SMILES: C=CC(=O)NCC1CCC(C2CCC(CCCCC)CC2)CC1] |
| 1β-4-130 | 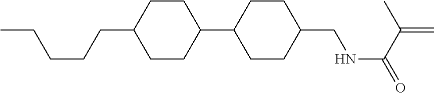 [SMILES: C=C(C)C(=O)NCC1CCC(C2CCC(CCCCC)CC2)CC1] |
| 1β-4-131 | 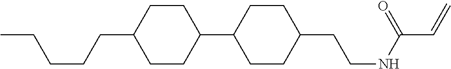 [SMILES: C=CC(=O)NCCC1CCC(C2CCC(CCCCC)CC2)CC1] |
| 1β-4-132 | 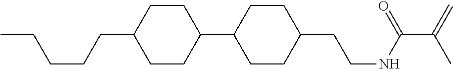 [SMILES: C=C(C)C(=O)NCCC1CCC(C2CCC(CCCCC)CC2)CC1] |
| 1β-4-133 | 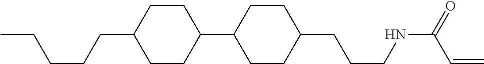 [SMILES: C=CC(=O)NCCCC1CCC(C2CCC(CCCCC)CC2)CC1] |
| 1β-4-134 | 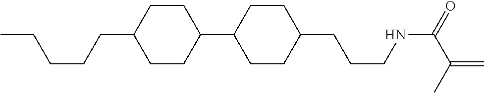 [SMILES: C=C(C)C(=O)NCCCC1CCC(C2CCC(CCCCC)CC2)CC1] |
| 1β-4-135 | 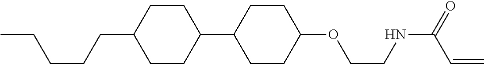 [SMILES: C=CC(=O)NCCOC1CCC(C2CCC(CCCCC)CC2)CC1] |
| 1β-4-136 | 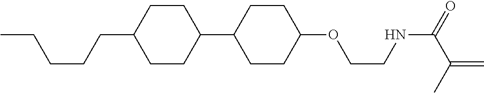 [SMILES: C=C(C)C(=O)NCCOC1CCC(C2CCC(CCCCC)CC2)CC1] |
| 1β-4-137 | 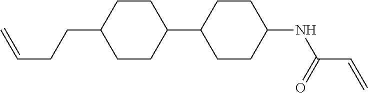 [SMILES: C=CCCC1CCC(C2CCC(NC(=O)C=C)CC2)CC1] |
| 1β-4-138 | 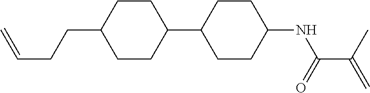 [SMILES: C=CCCC1CCC(C2CCC(NC(=O)C(=C)C)CC2)CC1] |
| 1β-4-139 | 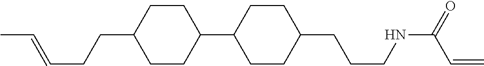 [SMILES: C=CC(=O)NCCCC1CCC(C2CCC(CC/C=C/C)CC2)CC1] |
| 1β-4-140 | 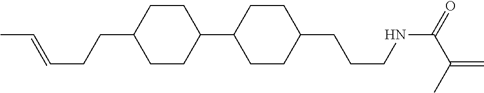 [SMILES: C=C(C)C(=O)NCCCC1CCC(C2CCC(CC/C=C/C)CC2)CC1] |
| 1β-4-141 | 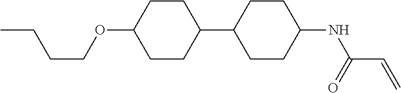 [SMILES: C=CC(=O)NC1CCC(C2CCC(OCCCC)CC2)CC1] |
| 1β-4-142 | 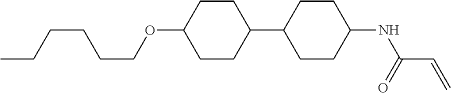 [SMILES: C=CC(=O)NC1CCC(C2CCC(OCCCCCC)CC2)CC1] |
| 1β-4-143 | 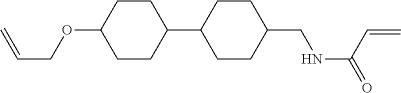 [SMILES: C=CCOC1CCC(C2CCC(CNC(=O)C=C)CC2)CC1] |
| 1β-4-144 | 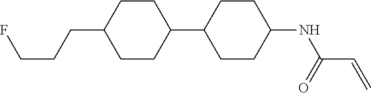 [SMILES: C=CC(=O)NC1CCC(C2CCC(CCCF)CC2)CC1] |
| 1β-4-145 | 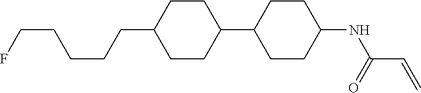 [SMILES: C=CC(=O)NC1CCC(C2CCC(CCCCCF)CC2)CC1] |
| 1β-4-146 | 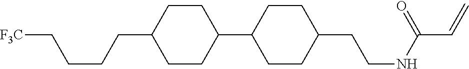 [SMILES: C=CC(=O)NCCC1CCC(C2CCC(CCCCC(F)(F)F)CC2)CC1] |
| 1β-4-147 | 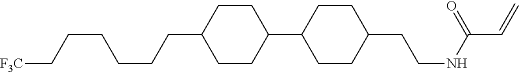 [SMILES: C=CC(=O)NCCC1CCC(C2CCC(CCCCCCC(F)(F)F)CC2)CC1] |
| 1β-4-148 | 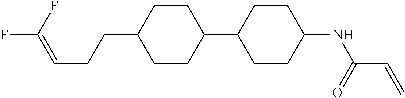 [SMILES: C=CC(=O)NC1CCC(C2CCC(CCC=C(F)F)CC2)CC1] |
| 1β-4-149 | 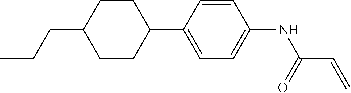 [SMILES: C=CC(=O)Nc1ccc(C2CCC(CCC)CC2)cc1] |
| 1β-4-150 | 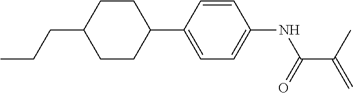 [SMILES: C=C(C)C(=O)Nc1ccc(C2CCC(CCC)CC2)cc1] |
| 1β-4-151 | 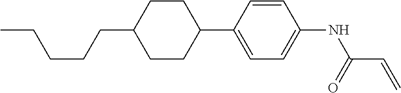 [SMILES: C=CC(=O)Nc1ccc(C2CCC(CCCCC)CC2)cc1] |
| 1β-4-152 | 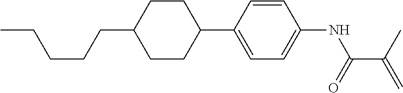 [SMILES: C=C(C)C(=O)Nc1ccc(C2CCC(CCCCC)CC2)cc1] |
| 1β-4-153 | 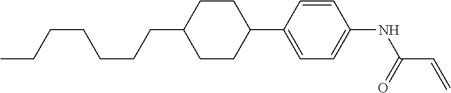 [SMILES: C=CC(=O)Nc1ccc(C2CCC(CCCCCCC)CC2)cc1] |
| 1β-4-154 | 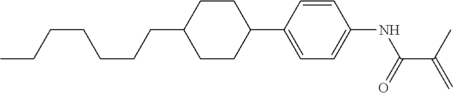 [SMILES: C=C(C)C(=O)Nc1ccc(C2CCC(CCCCCCC)CC2)cc1] |
| 1β-4-155 | 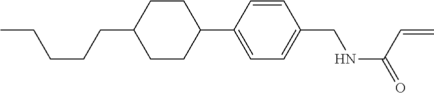 [SMILES: C=CC(=O)NCc1ccc(C2CCC(CCCCC)CC2)cc1] |
| 1β-4-156 | 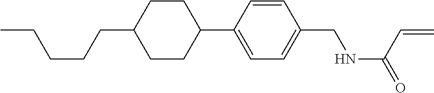 [SMILES: C=CC(=O)NCc1ccc(C2CCC(CCCCC)CC2)cc1] |
| 1β-4-157 | 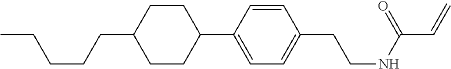 [SMILES: C=CC(=O)NCCc1ccc(C2CCC(CCCCC)CC2)cc1] |
| 1β-4-158 | 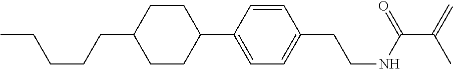 [SMILES: C=C(C)C(=O)NCCc1ccc(C2CCC(CCCCC)CC2)cc1] |
| 1β-4-159 | 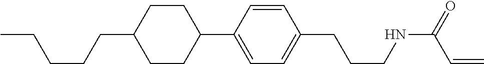 [SMILES: C=CC(=O)NCCCc1ccc(C2CCC(CCCCC)CC2)cc1] |
| 1β-4-160 | 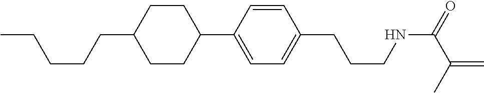 [SMILES: C=C(C)C(=O)NCCCc1ccc(C2CCC(CCCCC)CC2)cc1] |
| 1β-4-161 | 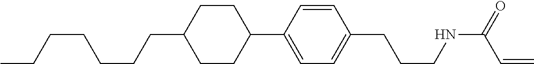 [SMILES: C=CC(=O)NCCCc1ccc(C2CCC(CCCCCCC)CC2)cc1] |
| 1β-4-162 | 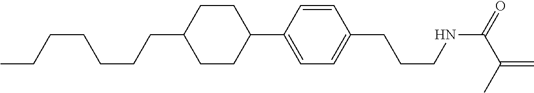 [SMILES: C=C(C)C(=O)NCCCc1ccc(C2CCC(CCCCCCC)CC2)cc1] |
| 1β-4-163 | 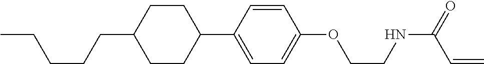 [SMILES: C=CC(=O)NCCOc1ccc(C2CCC(CCCCC)CC2)cc1] |
| 1β-4-164 | 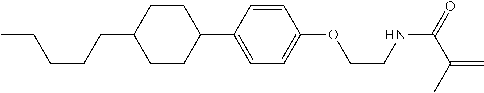 [SMILES: C=C(C)C(=O)NCCOc1ccc(C2CCC(CCCCC)CC2)cc1] |
| 1β-4-165 | 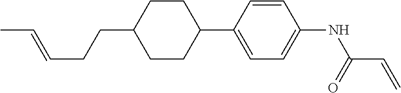 [SMILES: C=CC(=O)Nc1ccc(C2CCC(CC/C=C/C)CC2)cc1] |
| 1β-4-166 | 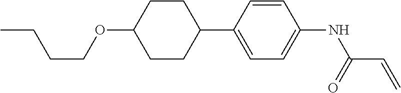 [SMILES: C=CC(=O)Nc1ccc(C2CCC(OCCCC)CC2)cc1] |
| 1β-4-167 | 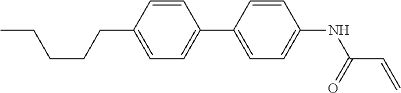 [SMILES: C=CC(=O)Nc1ccc(-c2ccc(CCCCC)cc2)cc1] |
| 1β-4-168 | 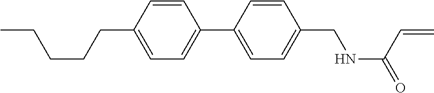 [SMILES: C=CC(=O)NCc1ccc(-c2ccc(CCCCC)cc2)cc1] |
| 1β-4-169 | 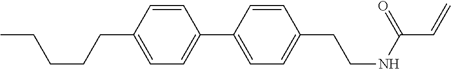 [SMILES: C=CC(=O)NCCc1ccc(-c2ccc(CCCCC)cc2)cc1] |
| 1β-4-170 | 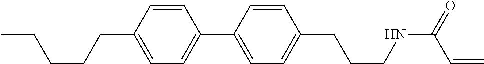 [SMILES: C=CC(=O)NCCCc1ccc(-c2ccc(CCCCC)cc2)cc1] |
| 1β-4-171 | 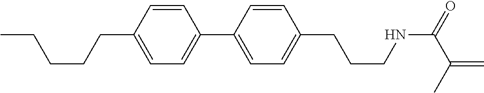 [SMILES: C=C(C)C(=O)NCCCc1ccc(-c2ccc(CCCCC)cc2)cc1] |
| 1β-4-172 | 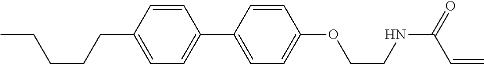 [SMILES: C=CC(=O)NCCOc1ccc(-c2ccc(CCCCC)cc2)cc1] |
| 1β-4-173 | 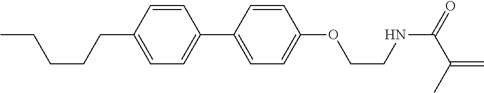 [SMILES: C=C(C)C(=O)NCCOc1ccc(-c2ccc(CCCCC)cc2)cc1] |
| 1β-4-174 | 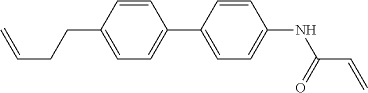 [SMILES: C=CCCc1ccc(-c2ccc(NC(=O)C=C)cc2)cc1] |
| 1β-4-175 | 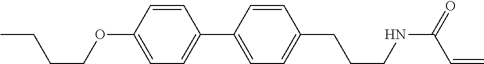 [SMILES: C=CC(=O)NCCCc1ccc(-c2ccc(OCCCC)cc2)cc1] |
| 1β-4-176 | 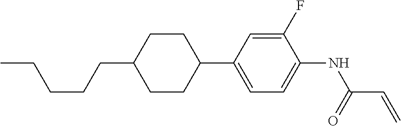 [SMILES: C=CC(=O)Nc1ccc(C2CCC(CCCCC)CC2)cc1F] |
| 1β-4-177 | 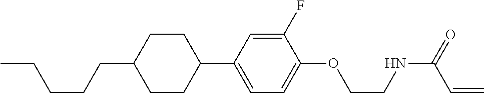 [SMILES: C=CC(=O)NCCOc1ccc(C2CCC(CCCCC)CC2)cc1F] |
| 1β-4-178 | 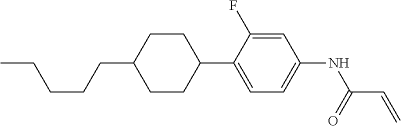 [SMILES: C=CC(=O)Nc1ccc(C2CCC(CCCCC)CC2)c(F)c1] |
| 1β-4-179 | 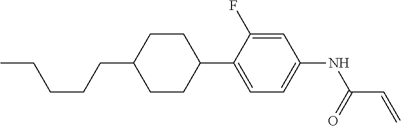 [SMILES: C=CC(=O)Nc1ccc(C2CCC(CCCCC)CC2)c(F)c1] |
| 1β-4-180 | 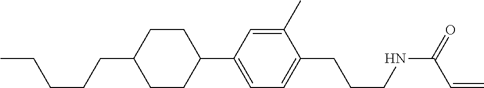 [SMILES: C=CC(=O)NCCCc1ccc(C2CCC(CCCCC)CC2)cc1C] |
| 1β-4-181 | 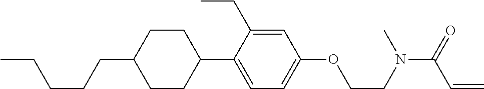 [SMILES: C=CC(=O)N(C)CCOc1ccc(C2CCC(CCCCC)CC2)c(CC)c1] |
| 1β-4-182 | 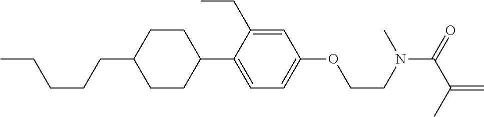 [SMILES: C=C(C)C(=O)N(C)CCOc1ccc(C2CCC(CCCCC)CC2)c(CC)c1] |
| 1β-4-183 | 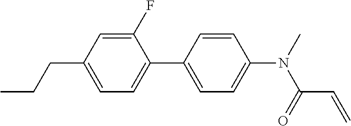 [SMILES: C=CC(=O)N(C)c1ccc(-c2ccc(CCC)cc2F)cc1] |
| 1β-4-184 | 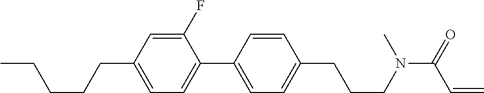 [SMILES: C=CC(=O)N(C)CCCc1ccc(-c2ccc(CCCCC)cc2F)cc1] |
| 1β-4-185 | 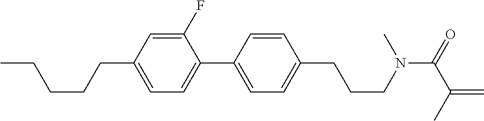 [SMILES: C=C(C)C(=O)N(C)CCCc1ccc(-c2ccc(CCCCC)cc2F)cc1] |
| 1β-4-186 | 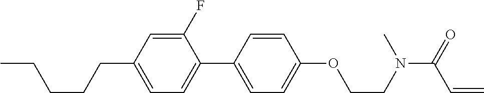 [SMILES: C=CC(=O)N(C)CCOc1ccc(-c2ccc(CCCCC)cc2F)cc1] |
| 1β-4-187 | 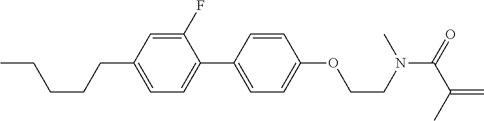 [SMILES: C=C(C)C(=O)N(C)CCOc1ccc(-c2ccc(CCCCC)cc2F)cc1] |
| 1β-4-188 | 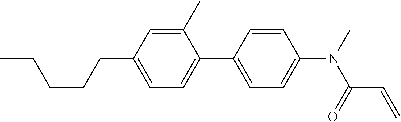 [SMILES: C=CC(=O)N(C)c1ccc(-c2ccc(CCCCC)cc2C)cc1] |
| 1β-4-189 | 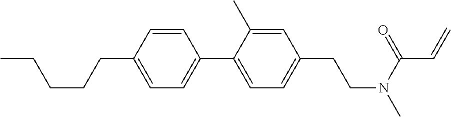 [SMILES: C=CC(=O)N(C)CCc1ccc(-c2ccc(CCCCC)cc2)c(C)c1] |
| 1β-4-190 | 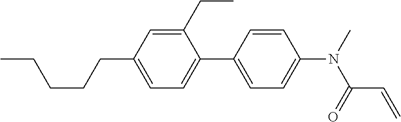 [SMILES: C=CC(=O)N(C)c1ccc(-c2ccc(CCCCC)cc2CC)cc1] |
| 1β-4-191 | 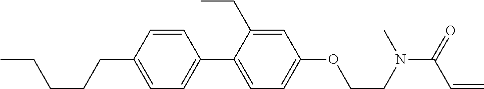 [SMILES: C=CC(=O)N(C)CCOc1ccc(-c2ccc(CCCCC)cc2)c(CC)c1] |
| 1β-4-192 | 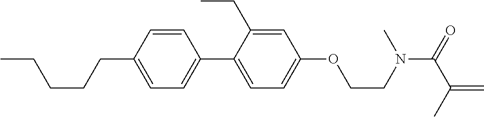 [SMILES: C=C(C)C(=O)N(C)CCOc1ccc(-c2ccc(CCCCC)cc2)c(CC)c1] |
| 1β-4-193 | 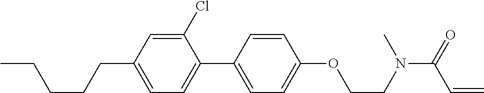 [SMILES: C=CC(=O)N(C)CCOc1ccc(-c2ccc(CCCCC)cc2Cl)cc1] |
| 1β-4-194 | 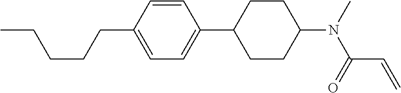 [SMILES: C=CC(=O)N(C)C1CCC(c2ccc(CCCCC)cc2)CC1] |
| 1β-4-195 | 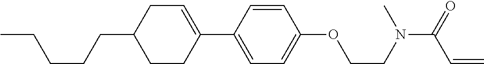 [SMILES: C=CC(=O)N(C)CCOc1ccc(C2=CCC(CCCCC)CC2)cc1] |
| 1β-4-196 | 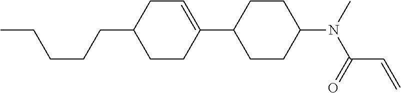 [SMILES: C=CC(=O)N(C)C1CCC(C2=CCC(CCCCC)CC2)CC1] |
| 1β-4-197 | 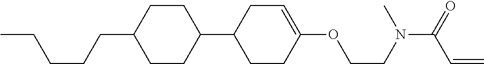 [SMILES: C=CC(=O)N(C)CCOC1=CCC(C2CCC(CCCCC)CC2)CC1] |
| 1β-4-198 | 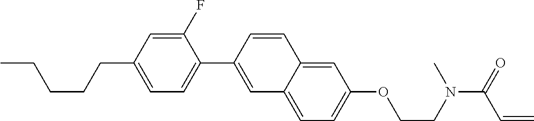 [SMILES: C=CC(=O)N(C)CCOc1ccc2cc(-c3ccc(CCCCC)cc3F)ccc2c1] |
| 1β-4-199 | 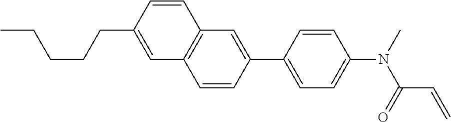 [SMILES: C=CC(=O)N(C)c1ccc(-c2ccc3cc(CCCCC)ccc3c2)cc1] |
| 1β-4-200 | 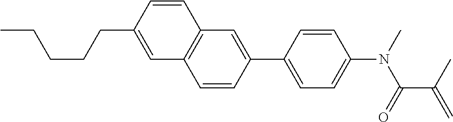 [SMILES: C=C(C)C(=O)N(C)c1ccc(-c2ccc3cc(CCCCC)ccc3c2)cc1] |
| 1β-4-201 | 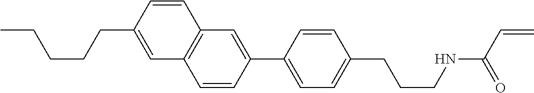 [SMILES: C=CC(=O)NCCCc1ccc(-c2ccc3cc(CCCCC)ccc3c2)cc1] |
| 1β-4-202 | 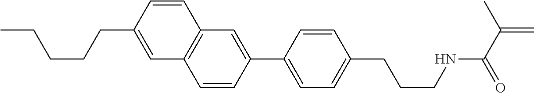 [SMILES: C=C(C)C(=O)NCCCc1ccc(-c2ccc3cc(CCCCC)ccc3c2)cc1] |
| 1β-4-203 | 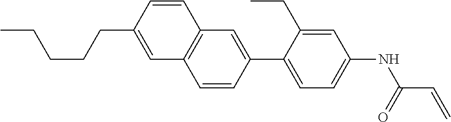 [SMILES: C=CC(=O)Nc1ccc(-c2ccc3cc(CCCCC)ccc3c2)c(CC)c1] |
| 1β-4-204 | 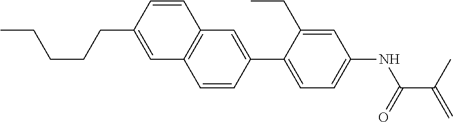 [SMILES: C=C(C)C(=O)Nc1ccc(-c2ccc3cc(CCCCC)ccc3c2)c(CC)c1] |
| 1β-4-205 | 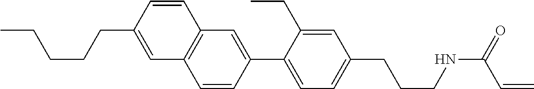 [SMILES: C=CC(=O)NCCCc1ccc(-c2ccc3cc(CCCCC)ccc3c2)c(CC)c1] |
| 1β-4-206 | 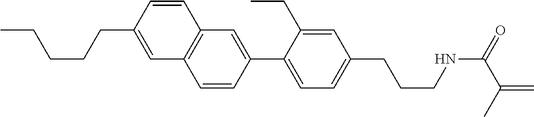 [SMILES: C=C(C)C(=O)NCCCc1ccc(-c2ccc3cc(CCCCC)ccc3c2)c(CC)c1] |
| 1β-4-207 | 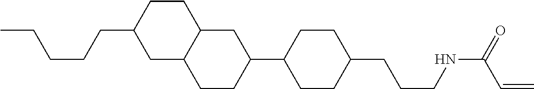 [SMILES: C=CC(=O)NCCCC1CCC(C2CCC3CC(CCCCC)CCC3C2)CC1] |
| 1β-4-208 | 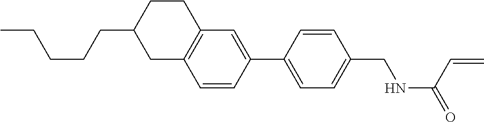 [SMILES: C=CC(=O)NCc1ccc(-c2ccc3c(c2)CCC(CCCCC)C3)cc1] |
| 1β-4-209 | 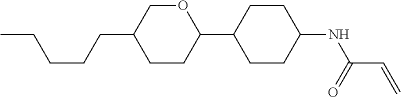 [SMILES: C=CC(=O)NC1CCC(C2CCC(CCCCC)CO2)CC1] |
| 1β-4-210 | 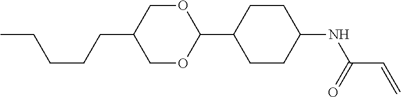 [SMILES: C=CC(=O)NC1CCC(C2OCC(CCCCC)CO2)CC1] |
| 1β-4-211 | 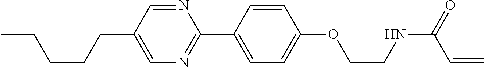 [SMILES: C=CC(=O)NCCOc1ccc(-c2ncc(CCCCC)cn2)cc1] |
| 1β-4-212 | 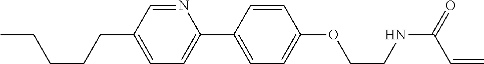 [SMILES: C=CC(=O)NCCOc1ccc(-c2ccc(CCCCC)cn2)cc1] |
| 1β-4-213 | 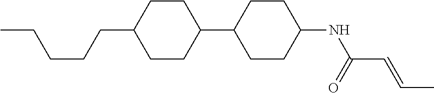 [SMILES: C/C=C/C(=O)NC1CCC(C2CCC(CCCCC)CC2)CC1] |
| 1β-4-214 | 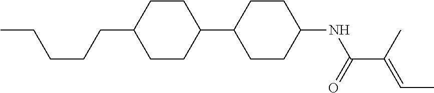 [SMILES: C/C=C(\C)C(=O)NC1CCC(C2CCC(CCCCC)CC2)CC1] |
| 1β-4-215 | 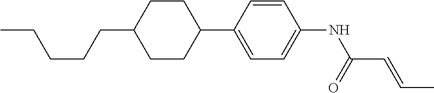 [SMILES: C/C=C/C(=O)Nc1ccc(C2CCC(CCCCC)CC2)cc1] |
| 1β-4-216 | 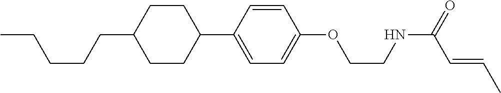 [SMILES: C/C=C/C(=O)NCCOc1ccc(C2CCC(CCCCC)CC2)cc1] |
| 1β-4-217 | 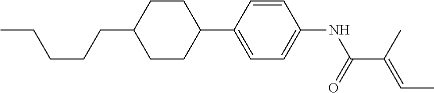 [SMILES: C/C=C(\C)C(=O)Nc1ccc(C2CCC(CCCCC)CC2)cc1] |
| 1β-4-218 | 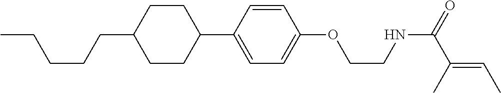 [SMILES: C/C=C(\C)C(=O)NCCOc1ccc(C2CCC(CCCCC)CC2)cc1] |
| 1β-4-219 | 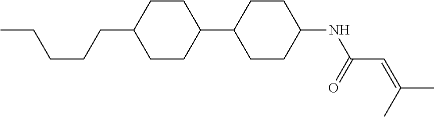 [SMILES: CCCCCC1CCC(C2CCC(NC(=O)C=C(C)C)CC2)CC1] |
| 1β-4-220 | 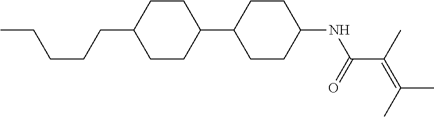 [SMILES: CCCCCC1CCC(C2CCC(NC(=O)C(C)=C(C)C)CC2)CC1] |
| 1β-4-221 | 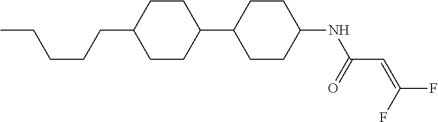 [SMILES: CCCCCC1CCC(C2CCC(NC(=O)C=C(F)F)CC2)CC1] |
| 1β-4-222 | 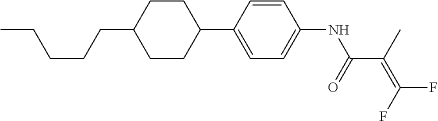 [SMILES: CCCCCC1CCC(c2ccc(NC(=O)C(C)=C(F)F)cc2)CC1] |
| 1β-4-223 | 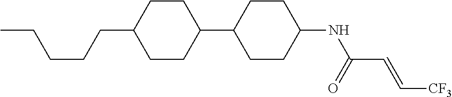 [SMILES: CCCCCC1CCC(C2CCC(NC(=O)/C=C/C(F)(F)F)CC2)CC1] |
| 1β-4-224 | 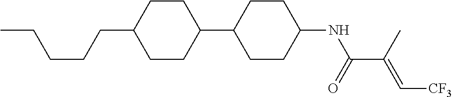 [SMILES: CCCCCC1CCC(C2CCC(NC(=O)/C(C)=C/C(F)(F)F)CC2)CC1] |
| 1β-4-225 | 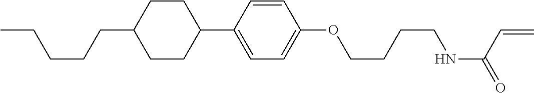 [SMILES: C=CC(=O)NCCCCOc1ccc(C2CCC(CCCCC)CC2)cc1] |
| 1β-4-226 | 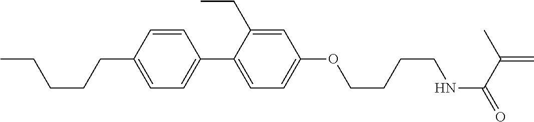 [SMILES: C=C(C)C(=O)NCCCCOc1ccc(-c2ccc(CCCCC)cc2)c(CC)c1] |
| 1β-4-227 | 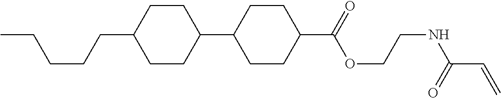 [SMILES: C=CC(=O)NCCOC(=O)C1CCC(C2CCC(CCCCC)CC2)CC1] |
| 1β-4-228 | 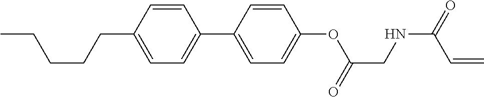 [SMILES: C=CC(=O)NCC(=O)Oc1ccc(-c2ccc(CCCCC)cc2)cc1] |
| 1β-4-229 | 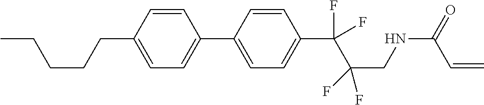 [SMILES: C=CC(=O)NCC(F)(F)C(F)(F)c1ccc(-c2ccc(CCCCC)cc2)cc1] |
| 1β-4-230 | 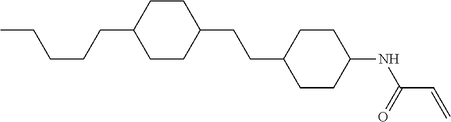 [SMILES: C=CC(=O)NC1CCC(CCC2CCC(CCCCC)CC2)CC1] |
| 1β-4-231 | 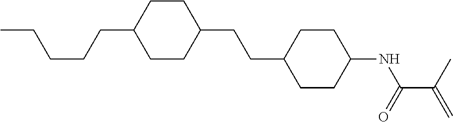 [SMILES: C=C(C)C(=O)NC1CCC(CCC2CCC(CCCCC)CC2)CC1] |
| 1β-4-232 | 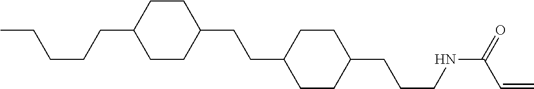 [SMILES: C=CC(=O)NCCCC1CCC(CCC2CCC(CCCCC)CC2)CC1] |
| 1β-4-233 | 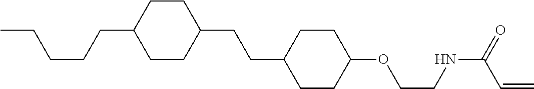 [SMILES: C=CC(=O)NCCOC1CCC(CCC2CCC(CCCCC)CC2)CC1] |
| 1β-4-234 | 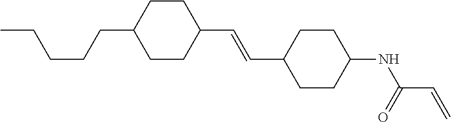 [SMILES: C=CC(=O)NC1CCC(/C=C/C2CCC(CCCCC)CC2)CC1] |
| 1β-4-235 | 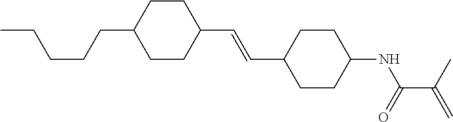 [SMILES: C=C(C)C(=O)NC1CCC(/C=C/C2CCC(CCCCC)CC2)CC1] |
| 1β-4-236 | 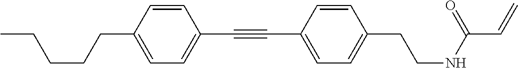 [SMILES: C=CC(=O)NCCc1ccc(C#Cc2ccc(CCCCC)cc2)cc1] |
| 1β-4-237 | 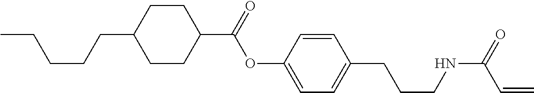 [SMILES: C=CC(=O)NCCCc1ccc(OC(=O)C2CCC(CCCCC)CC2)cc1] |
| 1β-4-238 | 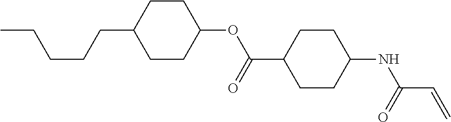 [SMILES: C=CC(=O)NC1CCC(C(=O)OC2CCC(CCCCC)CC2)CC1] |
| 1β-4-239 | 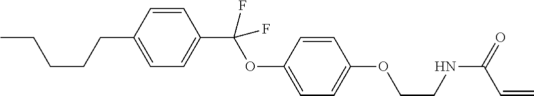 [SMILES: C=CC(=O)NCCOc1ccc(OC(F)(F)c2ccc(CCCCC)cc2)cc1] |
| 1β-4-240 | 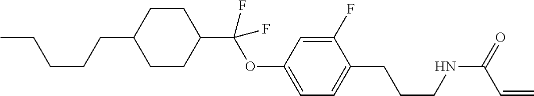 [SMILES: C=CC(=O)NCCCc1ccc(OC(F)(F)C2CCC(CCCCC)CC2)cc1F] |
| 1β-4-241 | 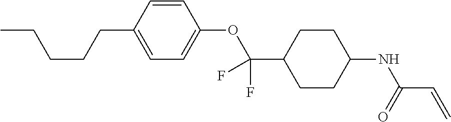 [SMILES: C=CC(=O)NC1CCC(C(F)(F)Oc2ccc(CCCCC)cc2)CC1] |
| 1β-4-242 | 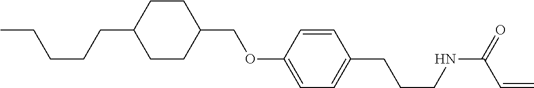 [SMILES: C=CC(=O)NCCCc1ccc(OCC2CCC(CCCCC)CC2)cc1] |
| 1β-4-243 | 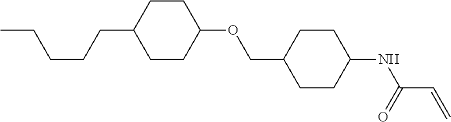 [SMILES: C=CC(=O)NC1CCC(COC2CCC(CCCCC)CC2)CC1] |
| 1β-4-244 | 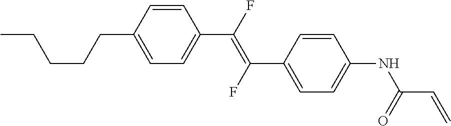 [SMILES: C=CC(=O)Nc1ccc(/C(F)=C(\F)c2ccc(CCCCC)cc2)cc1] |
| 1β-5-1 | 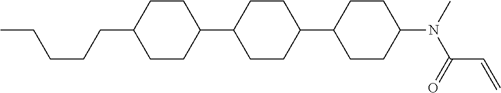 [SMILES: C=CC(=O)N(C)C1CCC(C2CCC(C3CCC(CCCCC)CC3)CC2)CC1] |
| 1β-5-2 | 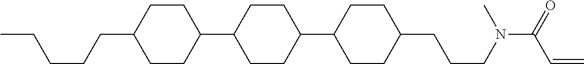 [SMILES: C=CC(=O)N(C)CCCC1CCC(C2CCC(C3CCC(CCCCC)CC3)CC2)CC1] |
| 1β-5-3 | 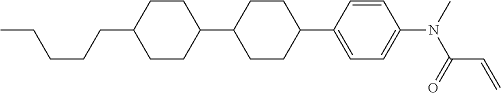 [SMILES: C=CC(=O)N(C)c1ccc(C2CCC(C3CCC(CCCCC)CC3)CC2)cc1] |
| 1β-5-4 | 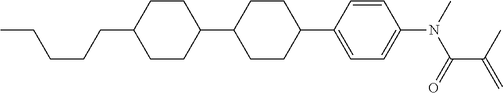 [SMILES: C=C(C)C(=O)N(C)c1ccc(C2CCC(C3CCC(CCCCC)CC3)CC2)cc1] |
| 1β-5-5 | 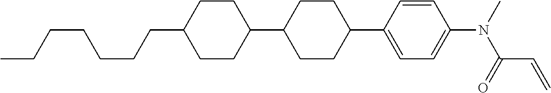 [SMILES: C=CC(=O)N(C)c1ccc(C2CCC(C3CCC(CCCCCCC)CC3)CC2)cc1] |
| 1β-5-6 | 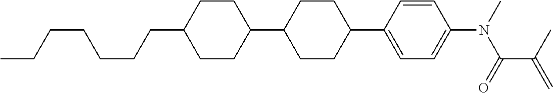 [SMILES: C=C(C)C(=O)N(C)c1ccc(C2CCC(C3CCC(CCCCCCC)CC3)CC2)cc1] |
| 1β-5-7 | 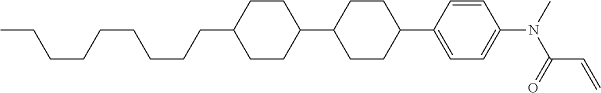 [SMILES: C=CC(=O)N(C)c1ccc(C2CCC(C3CCC(CCCCCCCCC)CC3)CC2)cc1] |
| 1β-5-8 | 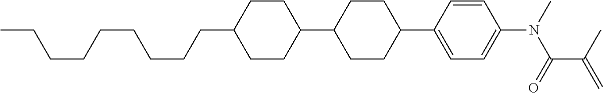 [SMILES: C=C(C)C(=O)N(C)c1ccc(C2CCC(C3CCC(CCCCCCCCC)CC3)CC2)cc1] |
| 1β-5-9 | 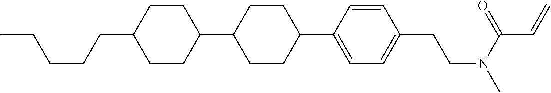 [SMILES: C=CC(=O)N(C)CCc1ccc(C2CCC(C3CCC(CCCCC)CC3)CC2)cc1] |
| 1β-5-10 | 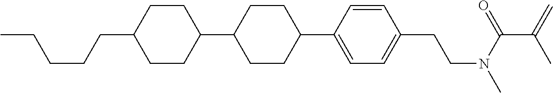 [SMILES: C=C(C)C(=O)N(C)CCc1ccc(C2CCC(C3CCC(CCCCC)CC3)CC2)cc1] |
| 1β-5-11 | 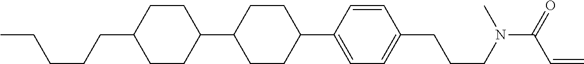 [SMILES: C=CC(=O)N(C)CCCc1ccc(C2CCC(C3CCC(CCCCC)CC3)CC2)cc1] |
| 1β-5-12 | 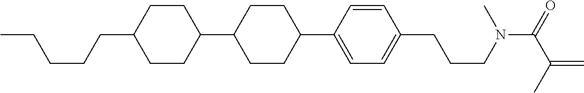 [SMILES: C=C(C)C(=O)N(C)CCCc1ccc(C2CCC(C3CCC(CCCCC)CC3)CC2)cc1] |
| 1β-5-13 | 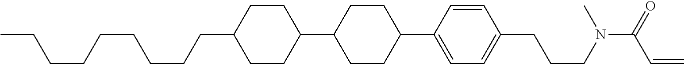 [SMILES: C=CC(=O)N(C)CCCc1ccc(C2CCC(C3CCC(CCCCCCCCC)CC3)CC2)cc1] |
| 1β-5-14 | 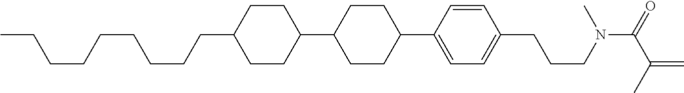 [SMILES: C=C(C)C(=O)N(C)CCCc1ccc(C2CCC(C3CCC(CCCCCCCCC)CC3)CC2)cc1] |
| 1β-5-15 | 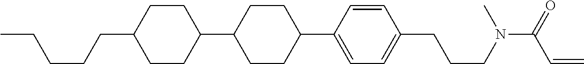 [SMILES: C=CC(=O)N(C)CCCc1ccc(C2CCC(C3CCC(CCCCC)CC3)CC2)cc1] |
| 1β-5-16 | 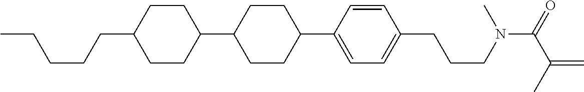 [SMILES: C=C(C)C(=O)N(C)CCCc1ccc(C2CCC(C3CCC(CCCCC)CC3)CC2)cc1] |
| 1β-5-17 | 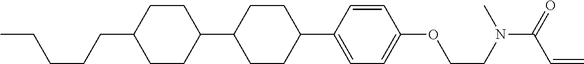 [SMILES: C=CC(=O)N(C)CCOc1ccc(C2CCC(C3CCC(CCCCC)CC3)CC2)cc1] |
| 1β-5-18 | 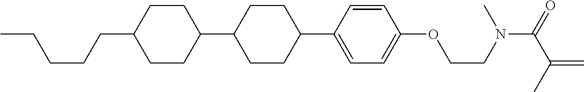 [SMILES: C=C(C)C(=O)N(C)CCOc1ccc(C2CCC(C3CCC(CCCCC)CC3)CC2)cc1] |
| 1β-5-19 | 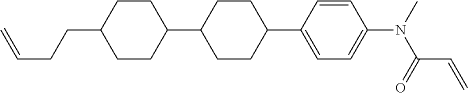 [SMILES: C=CCCC1CCC(C2CCC(c3ccc(N(C)C(=O)C=C)cc3)CC2)CC1] |
| 1β-5-20 | 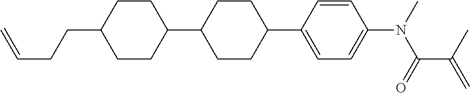 [SMILES: C=CCCC1CCC(C2CCC(c3ccc(N(C)C(=O)C(=C)C)cc3)CC2)CC1] |
| 1β-5-21 | 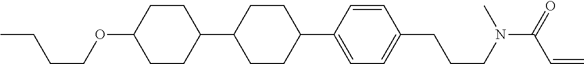 [SMILES: C=CC(=O)N(C)CCCc1ccc(C2CCC(C3CCC(OCCCC)CC3)CC2)cc1] |
| 1β-5-22 | 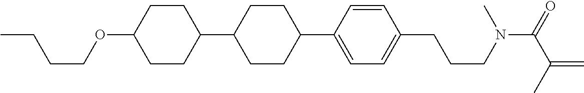 [SMILES: C=C(C)C(=O)N(C)CCCc1ccc(C2CCC(C3CCC(OCCCC)CC3)CC2)cc1] |
| 1β-5-23 | 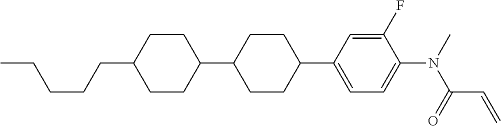 [SMILES: C=CC(=O)N(C)c1ccc(C2CCC(C3CCC(CCCCC)CC3)CC2)cc1F] |
| 1β-5-24 | 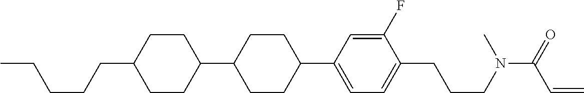 [SMILES: C=CC(=O)N(C)CCCc1ccc(C2CCC(C3CCC(CCCCC)CC3)CC2)cc1F] |
| 1β-5-25 | 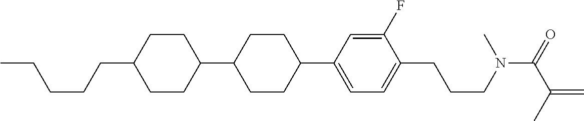 [SMILES: C=C(C)C(=O)N(C)CCCc1ccc(C2CCC(C3CCC(CCCCC)CC3)CC2)cc1F] |
| 1β-5-26 | 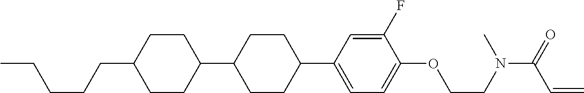 [SMILES: C=CC(=O)N(C)CCOc1ccc(C2CCC(C3CCC(CCCCC)CC3)CC2)cc1F] |
| 1β-5-27 | 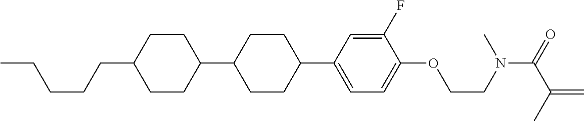 [SMILES: C=C(C)C(=O)N(C)CCOc1ccc(C2CCC(C3CCC(CCCCC)CC3)CC2)cc1F] |
| 1β-5-28 | 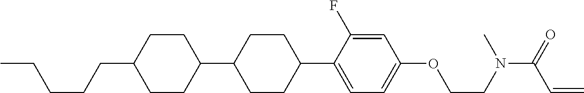 [SMILES: C=CC(=O)N(C)CCOc1ccc(C2CCC(C3CCC(CCCCC)CC3)CC2)c(F)c1] |
| 1β-5-29 | 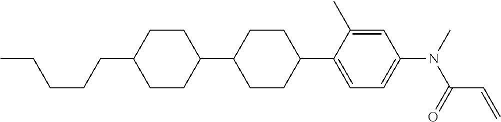 [SMILES: C=CC(=O)N(C)c1ccc(C2CCC(C3CCC(CCCCC)CC3)CC2)c(C)c1] |
| 1β-5-30 | 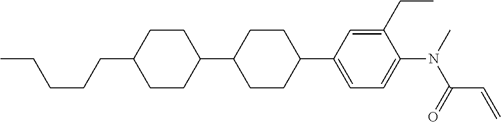 [SMILES: C=CC(=O)N(C)c1ccc(C2CCC(C3CCC(CCCCC)CC3)CC2)cc1CC] |
| 1β-5-31 | 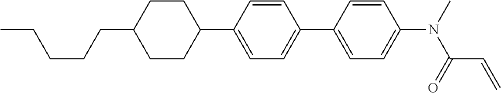 [SMILES: C=CC(=O)N(C)c1ccc(-c2ccc(C3CCC(CCCCC)CC3)cc2)cc1] |
| 1β-5-32 | 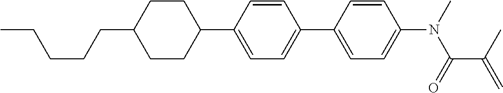 [SMILES: C=C(C)C(=O)N(C)c1ccc(-c2ccc(C3CCC(CCCCC)CC3)cc2)cc1] |
| 1β-5-33 | 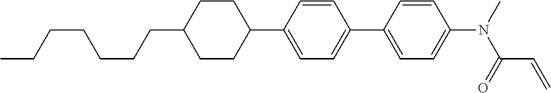 [SMILES: C=CC(=O)N(C)c1ccc(-c2ccc(C3CCC(CCCCCCC)CC3)cc2)cc1] |
| 1β-5-34 | 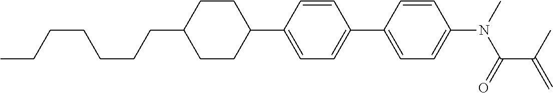 [SMILES: C=C(C)C(=O)N(C)c1ccc(-c2ccc(C3CCC(CCCCCCC)CC3)cc2)cc1] |
| 1β-5-35 | 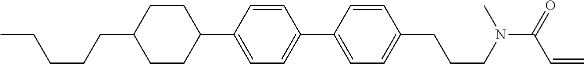 [SMILES: C=CC(=O)N(C)CCCc1ccc(-c2ccc(C3CCC(CCCCC)CC3)cc2)cc1] |
| 1β-5-36 | 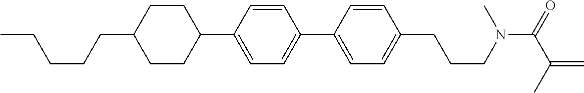 [SMILES: C=C(C)C(=O)N(C)CCCc1ccc(-c2ccc(C3CCC(CCCCC)CC3)cc2)cc1] |
| 1β-5-37 | 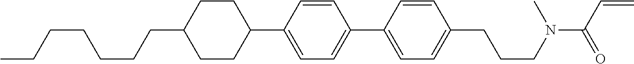 [SMILES: C=CC(=O)N(C)CCCc1ccc(-c2ccc(C3CCC(CCCCCCC)CC3)cc2)cc1] |
| 1β-5-38 | 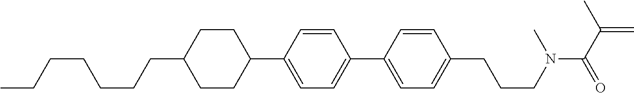 [SMILES: C=C(C)C(=O)N(C)CCCc1ccc(-c2ccc(C3CCC(CCCCCCC)CC3)cc2)cc1] |
| 1β-5-39 | 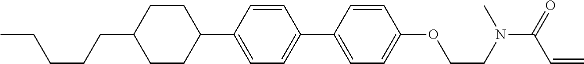 [SMILES: C=CC(=O)N(C)CCOc1ccc(-c2ccc(C3CCC(CCCCC)CC3)cc2)cc1] |
| 1β-5-40 | 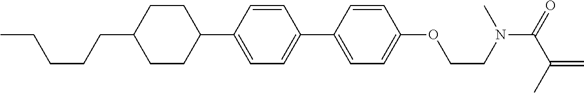 [SMILES: C=C(C)C(=O)N(C)CCOc1ccc(-c2ccc(C3CCC(CCCCC)CC3)cc2)cc1] |
| 1β-5-41 | 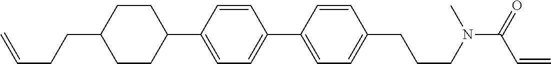 [SMILES: C=CCCC1CCC(c2ccc(-c3ccc(CCCN(C)C(=O)C=C)cc3)cc2)CC1] |
| 1β-5-42 | 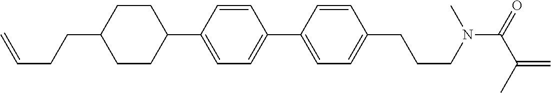 [SMILES: C=CCCC1CCC(c2ccc(-c3ccc(CCCN(C)C(=O)C(=C)C)cc3)cc2)CC1] |
| 1β-5-43 | 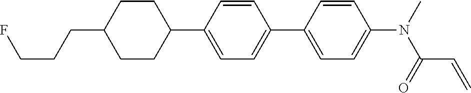 [SMILES: C=CC(=O)N(C)c1ccc(-c2ccc(C3CCC(CCCF)CC3)cc2)cc1] |
| 1β-5-44 | 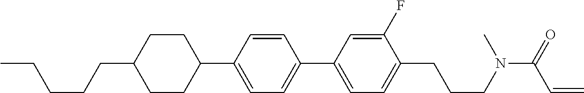 [SMILES: C=CC(=O)N(C)CCCc1ccc(-c2ccc(C3CCC(CCCCC)CC3)cc2)cc1F] |
| 1β-5-45 | 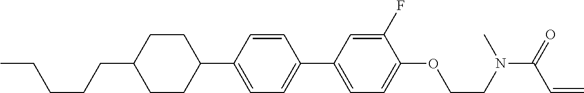 [SMILES: C=CC(=O)N(C)CCOc1ccc(-c2ccc(C3CCC(CCCCC)CC3)cc2)cc1F] |
| 1β-5-46 | 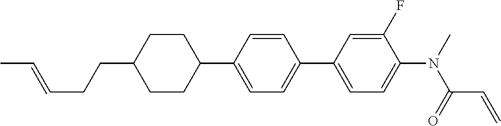 [SMILES: C=CC(=O)N(C)c1ccc(-c2ccc(C3CCC(CC/C=C/C)CC3)cc2)cc1F] |
| 1β-5-47 | 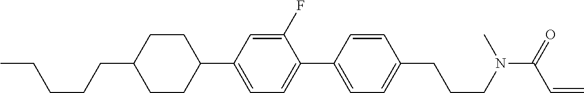 [SMILES: C=CC(=O)N(C)CCCc1ccc(-c2ccc(C3CCC(CCCCC)CC3)cc2F)cc1] |
| 1β-5-48 | 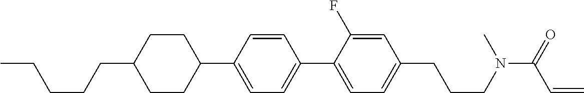 [SMILES: C=CC(=O)N(C)CCCc1ccc(-c2ccc(C3CCC(CCCCC)CC3)cc2)c(F)c1] |
| 1β-5-49 | 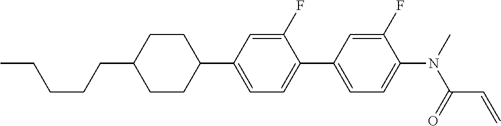 [SMILES: C=CC(=O)N(C)c1ccc(-c2ccc(C3CCC(CCCCC)CC3)cc2F)cc1F] |
| 1β-5-50 | 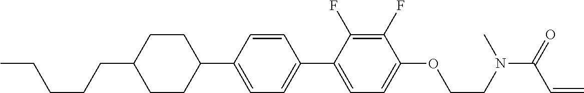 [SMILES: C=CC(=O)N(C)CCOc1ccc(-c2ccc(C3CCC(CCCCC)CC3)cc2)c(F)c1F] |
| 1β-5-51 | 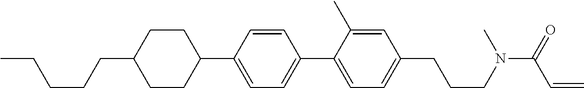 [SMILES: C=CC(=O)N(C)CCCc1ccc(-c2ccc(C3CCC(CCCCC)CC3)cc2)c(C)c1] |
| 1β-5-52 | 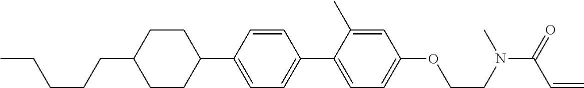 [SMILES: C=CC(=O)N(C)CCOc1ccc(-c2ccc(C3CCC(CCCCC)CC3)cc2)c(C)c1] |
| 1β-5-53 | 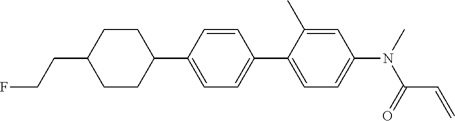 [SMILES: C=CC(=O)N(C)c1ccc(-c2ccc(C3CCC(CCF)CC3)cc2)c(C)c1] |
| 1β-5-54 | 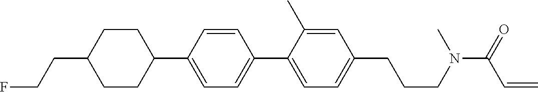 [SMILES: C=CC(=O)N(C)CCCc1ccc(-c2ccc(C3CCC(CCF)CC3)cc2)c(C)c1] |
| 1β-5-55 | 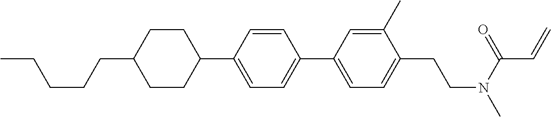 [SMILES: C=CC(=O)N(C)CCc1ccc(-c2ccc(C3CCC(CCCCC)CC3)cc2)cc1C] |
| 1β-5-56 | 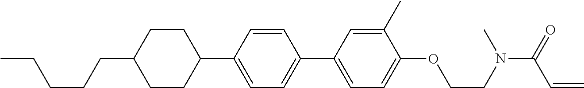 [SMILES: C=CC(=O)N(C)CCOc1ccc(-c2ccc(C3CCC(CCCCC)CC3)cc2)cc1C] |
| 1β-5-57 | 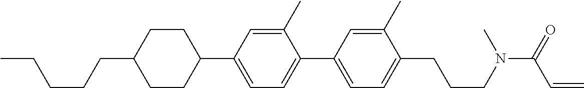 [SMILES: C=CC(=O)N(C)CCCc1ccc(-c2ccc(C3CCC(CCCCC)CC3)cc2C)cc1C] |
| 1β-5-58 | 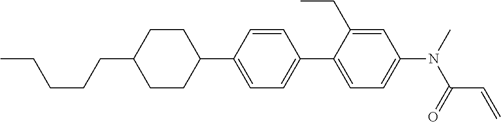 [SMILES: C=CC(=O)N(C)c1ccc(-c2ccc(C3CCC(CCCCC)CC3)cc2)c(CC)c1] |
| 1β-5-59 | 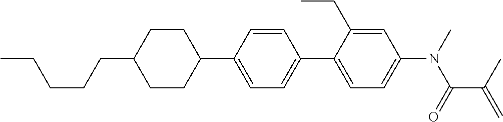 [SMILES: C=C(C)C(=O)N(C)c1ccc(-c2ccc(C3CCC(CCCCC)CC3)cc2)c(CC)c1] |
| 1β-5-60 | 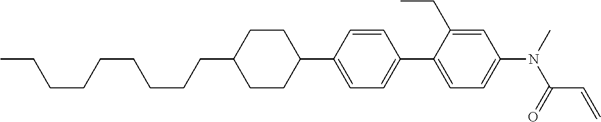 [SMILES: C=CC(=O)N(C)c1ccc(-c2ccc(C3CCC(CCCCCCCCC)CC3)cc2)c(CC)c1] |
| 1β-5-61 | 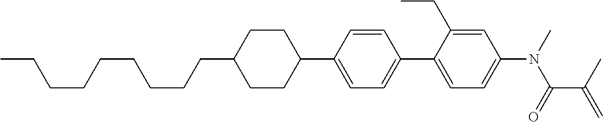 [SMILES: C=C(C)C(=O)N(C)c1ccc(-c2ccc(C3CCC(CCCCCCCCC)CC3)cc2)c(CC)c1] |
| 1β-5-62 | 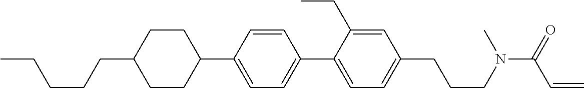 [SMILES: C=CC(=O)N(C)CCCc1ccc(-c2ccc(C3CCC(CCCCC)CC3)cc2)c(CC)c1] |
| 1β-5-63 | 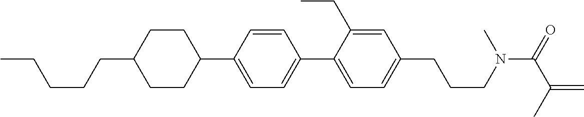 [SMILES: C=C(C)C(=O)N(C)CCCc1ccc(-c2ccc(C3CCC(CCCCC)CC3)cc2)c(CC)c1] |
| 1β-5-64 | 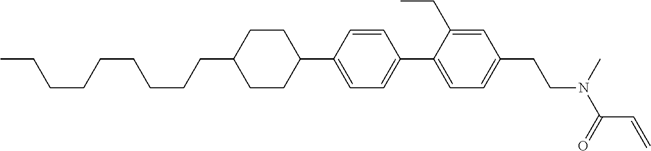 [SMILES: C=CC(=O)N(C)CCc1ccc(-c2ccc(C3CCC(CCCCCCCCC)CC3)cc2)c(CC)c1] |
| 1β-5-65 | 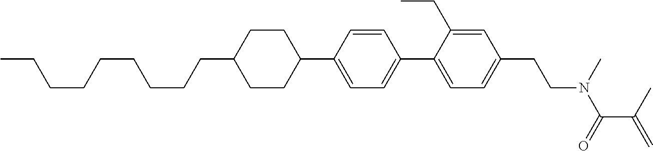 [SMILES: C=C(C)C(=O)N(C)CCc1ccc(-c2ccc(C3CCC(CCCCCCCCC)CC3)cc2)c(CC)c1] |
| 1β-5-66 | 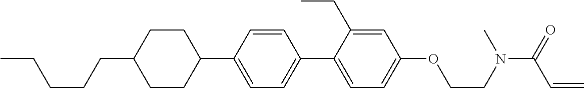 [SMILES: C=CC(=O)N(C)CCOc1ccc(-c2ccc(C3CCC(CCCCC)CC3)cc2)c(CC)c1] |
| 1β-5-67 | 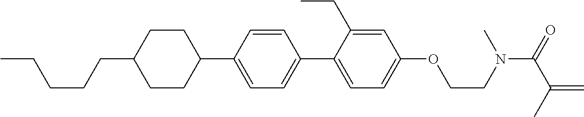 [SMILES: C=C(C)C(=O)N(C)CCOc1ccc(-c2ccc(C3CCC(CCCCC)CC3)cc2)c(CC)c1] |
| 1β-5-68 | 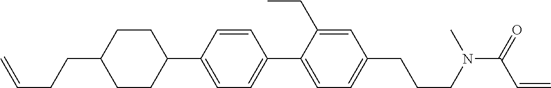 [SMILES: C=CCCC1CCC(c2ccc(-c3ccc(CCCN(C)C(=O)C=C)cc3CC)cc2)CC1] |
| 1β-5-69 | 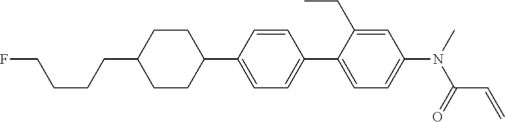 [SMILES: C=CC(=O)N(C)c1ccc(-c2ccc(C3CCC(CCCCF)CC3)cc2)c(CC)c1] |
| 1β-5-70 | 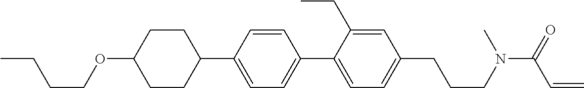 [SMILES: C=CC(=O)N(C)CCCc1ccc(-c2ccc(C3CCC(OCCCC)CC3)cc2)c(CC)c1] |
| 1β-5-71 | 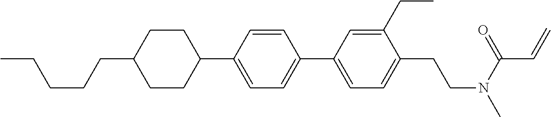 [SMILES: C=CC(=O)N(C)CCc1ccc(-c2ccc(C3CCC(CCCCC)CC3)cc2)cc1CC] |
| 1β-5-72 | 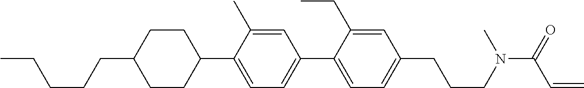 [SMILES: C=CC(=O)N(C)CCCc1ccc(-c2ccc(C3CCC(CCCCC)CC3)c(C)c2)c(CC)c1] |
| 1β-5-73 | 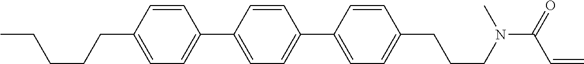 [SMILES: C=CC(=O)N(C)CCCc1ccc(-c2ccc(-c3ccc(CCCCC)cc3)cc2)cc1] |
| 1β-5-74 | 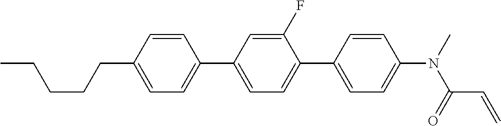 [SMILES: C=CC(=O)N(C)c1ccc(-c2ccc(-c3ccc(CCCCC)cc3)cc2F)cc1] |
| 1β-5-75 | 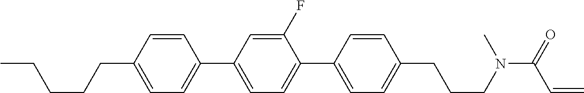 [SMILES: C=CC(=O)N(C)CCCc1ccc(-c2ccc(-c3ccc(CCCCC)cc3)cc2F)cc1] |
| 1β-5-76 | 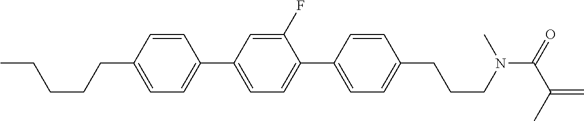 [SMILES: C=C(C)C(=O)N(C)CCCc1ccc(-c2ccc(-c3ccc(CCCCC)cc3)cc2F)cc1] |
| 1β-5-77 | 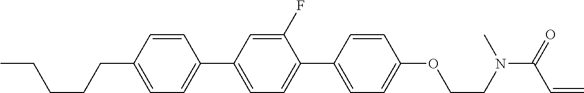 [SMILES: C=CC(=O)N(C)CCOc1ccc(-c2ccc(-c3ccc(CCCCC)cc3)cc2F)cc1] |
| 1β-5-78 | 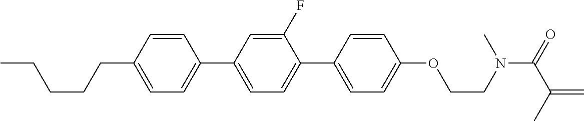 [SMILES: C=C(C)C(=O)N(C)CCOc1ccc(-c2ccc(-c3ccc(CCCCC)cc3)cc2F)cc1] |
| 1β-5-79 | 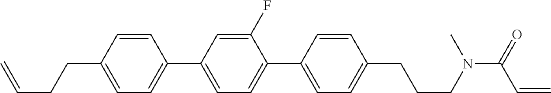 [SMILES: C=CCCc1ccc(-c2ccc(-c3ccc(CCCN(C)C(=O)C=C)cc3)c(F)c2)cc1] |
| 1β-5-80 | 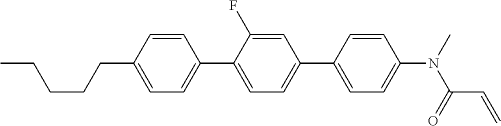 [SMILES: C=CC(=O)N(C)c1ccc(-c2ccc(-c3ccc(CCCCC)cc3)c(F)c2)cc1] |
| 1β-5-81 | 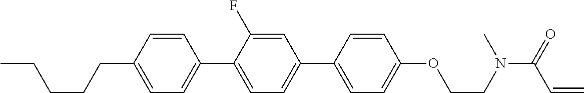 [SMILES: C=CC(=O)N(C)CCOc1ccc(-c2ccc(-c3ccc(CCCCC)cc3)c(F)c2)cc1] |
| 1β-5-82 | 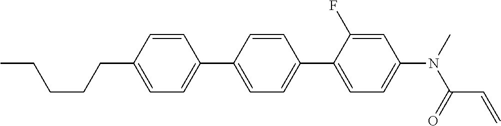 [SMILES: C=CC(=O)N(C)c1ccc(-c2ccc(-c3ccc(CCCCC)cc3)cc2)c(F)c1] |
| 1β-5-83 | 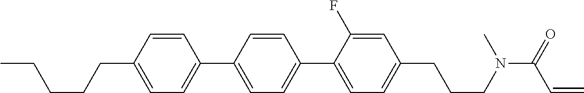 [SMILES: C=CC(=O)N(C)CCCc1ccc(-c2ccc(-c3ccc(CCCCC)cc3)cc2)c(F)c1] |
| 1β-5-84 | 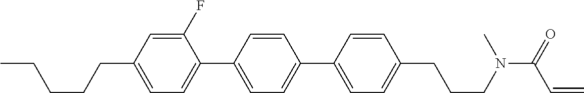 [SMILES: C=CC(=O)N(C)CCCc1ccc(-c2ccc(-c3ccc(CCCCC)cc3F)cc2)cc1] |
| 1β-5-85 | 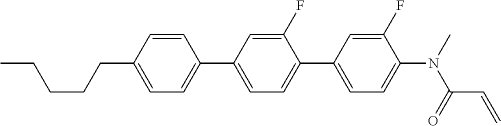 [SMILES: C=CC(=O)N(C)c1ccc(-c2ccc(-c3ccc(CCCCC)cc3)cc2F)cc1F] |
| 1β-5-86 | 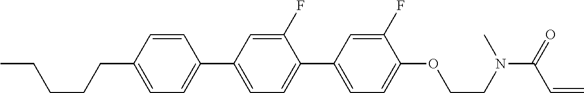 [SMILES: C=CC(=O)N(C)CCOc1ccc(-c2ccc(-c3ccc(CCCCC)cc3)cc2F)cc1F] |
| 1β-5-87 | 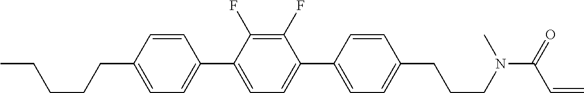 [SMILES: C=CC(=O)N(C)CCCc1ccc(-c2ccc(-c3ccc(CCCCC)cc3)c(F)c2F)cc1] |
| 1β-5-88 | 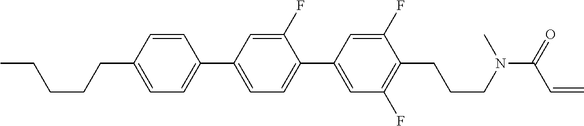 [SMILES: C=CC(=O)N(C)CCCc1c(F)cc(-c2ccc(-c3ccc(CCCCC)cc3)cc2F)cc1F] |
| 1β-5-89 | 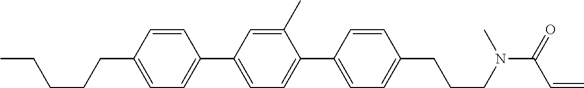 [SMILES: C=CC(=O)N(C)CCCc1ccc(-c2ccc(-c3ccc(CCCCC)cc3)cc2C)cc1] |
| 1β-5-90 | 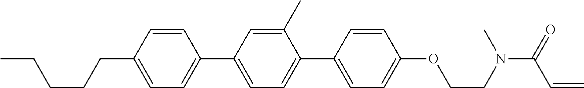 [SMILES: C=CC(=O)N(C)CCOc1ccc(-c2ccc(-c3ccc(CCCCC)cc3)cc2C)cc1] |
| 1β-5-91 | 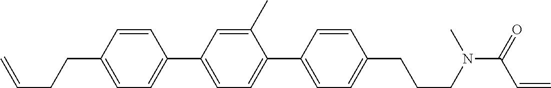 [SMILES: C=CCCc1ccc(-c2ccc(-c3ccc(CCCN(C)C(=O)C=C)cc3)c(C)c2)cc1] |
| 1β-5-92 | 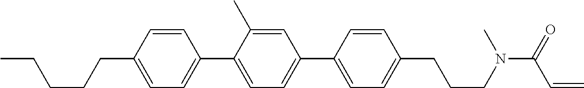 [SMILES: C=CC(=O)N(C)CCCc1ccc(-c2ccc(-c3ccc(CCCCC)cc3)c(C)c2)cc1] |
| 1β-5-93 | 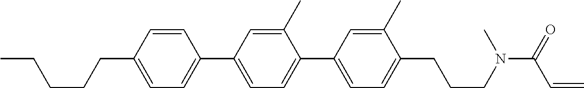 [SMILES: C=CC(=O)N(C)CCCc1ccc(-c2ccc(-c3ccc(CCCCC)cc3)cc2C)cc1C] |
| 1β-5-94 | 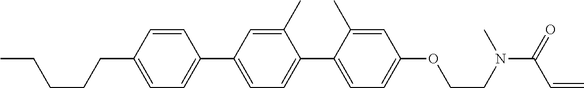 [SMILES: C=CC(=O)N(C)CCOc1ccc(-c2ccc(-c3ccc(CCCCC)cc3)cc2C)c(C)c1] |
| 1β-5-95 | 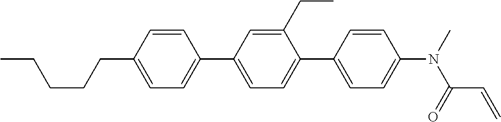 [SMILES: C=CC(=O)N(C)c1ccc(-c2ccc(-c3ccc(CCCCC)cc3)cc2CC)cc1] |
| 1β-5-96 | 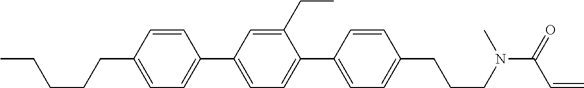 [SMILES: C=CC(=O)N(C)CCCc1ccc(-c2ccc(-c3ccc(CCCCC)cc3)cc2CC)cc1] |
| 1β-5-97 | 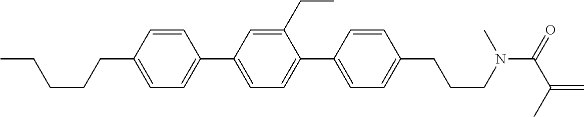 [SMILES: C=C(C)C(=O)N(C)CCCc1ccc(-c2ccc(-c3ccc(CCCCC)cc3)cc2CC)cc1] |
| 1β-5-98 | 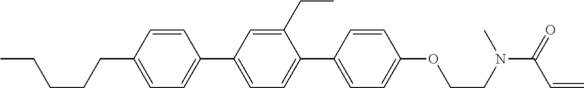 [SMILES: C=CC(=O)N(C)CCOc1ccc(-c2ccc(-c3ccc(CCCCC)cc3)cc2CC)cc1] |
| 1β-5-99 | 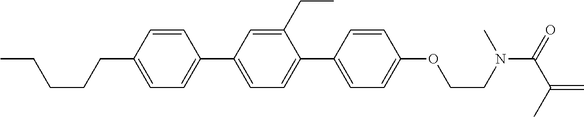 [SMILES: C=C(C)C(=O)N(C)CCOc1ccc(-c2ccc(-c3ccc(CCCCC)cc3)cc2CC)cc1] |
| 1β-5-100 | 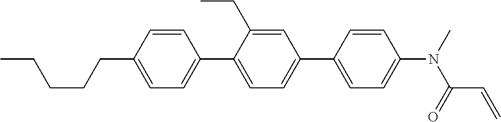 [SMILES: C=CC(=O)N(C)c1ccc(-c2ccc(-c3ccc(CCCCC)cc3)c(CC)c2)cc1] |
| 1β-5-101 | 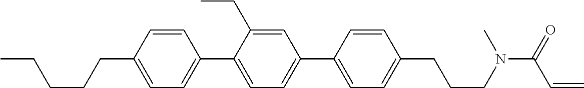 [SMILES: C=CC(=O)N(C)CCCc1ccc(-c2ccc(-c3ccc(CCCCC)cc3)c(CC)c2)cc1] |
| 1β-5-102 | 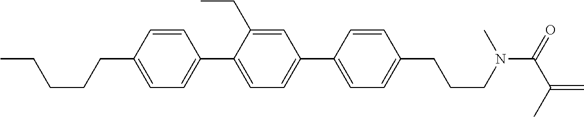 [SMILES: C=C(C)C(=O)N(C)CCCc1ccc(-c2ccc(-c3ccc(CCCCC)cc3)c(CC)c2)cc1] |
| 1β-5-103 | 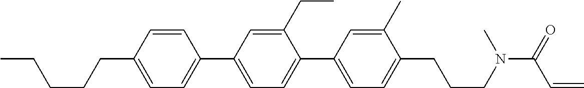 [SMILES: C=CC(=O)N(C)CCCc1ccc(-c2ccc(-c3ccc(CCCCC)cc3)cc2CC)cc1C] |
| 1β-5-104 | 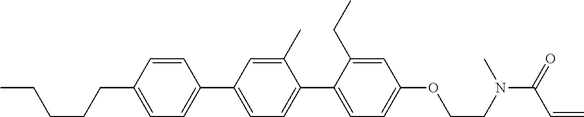 [SMILES: C=CC(=O)N(C)CCOc1ccc(-c2ccc(-c3ccc(CCCCC)cc3)cc2C)c(CC)c1] |
| 1β-5-105 | 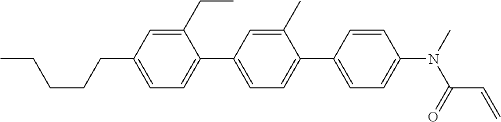 [SMILES: C=CC(=O)N(C)c1ccc(-c2ccc(-c3ccc(CCCCC)cc3CC)cc2C)cc1] |
| 1β-5-106 | 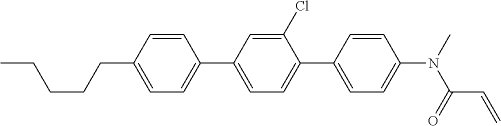 [SMILES: C=CC(=O)N(C)c1ccc(-c2ccc(-c3ccc(CCCCC)cc3)cc2Cl)cc1] |
| 1β-5-107 | 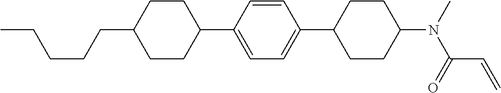 [SMILES: C=CC(=O)N(C)C1CCC(c2ccc(C3CCC(CCCCC)CC3)cc2)CC1] |
| 1β-5-108 | 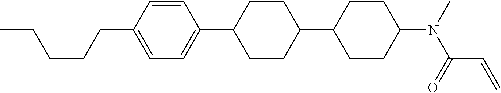 [SMILES: C=CC(=O)N(C)C1CCC(C2CCC(c3ccc(CCCCC)cc3)CC2)CC1] |
| 1β-5-109 | 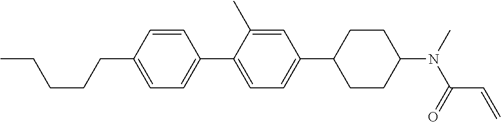 [SMILES: C=CC(=O)N(C)C1CCC(c2ccc(-c3ccc(CCCCC)cc3)c(C)c2)CC1] |
| 1β-5-110 | 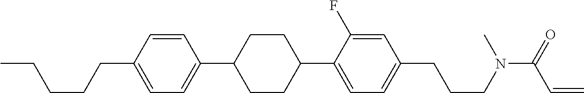 [SMILES: C=CC(=O)N(C)CCCc1ccc(C2CCC(c3ccc(CCCCC)cc3)CC2)c(F)c1] |
| 1β-5-111 | 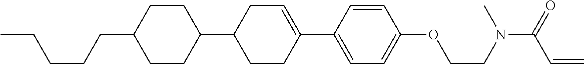 [SMILES: C=CC(=O)N(C)CCOc1ccc(C2=CCC(C3CCC(CCCCC)CC3)CC2)cc1] |
| 1β-5-112 | 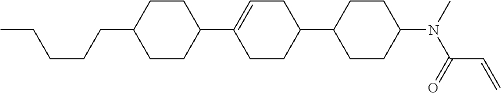 [SMILES: C=CC(=O)N(C)C1CCC(C2CC=C(C3CCC(CCCCC)CC3)CC2)CC1] |
| 1β-5-113 | 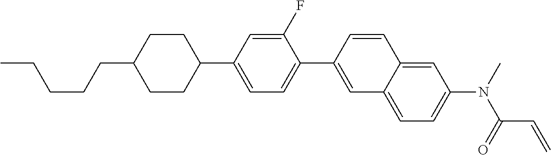 [SMILES: C=CC(=O)N(C)c1ccc2cc(-c3ccc(C4CCC(CCCCC)CC4)cc3F)ccc2c1] |
| 1β-5-114 | 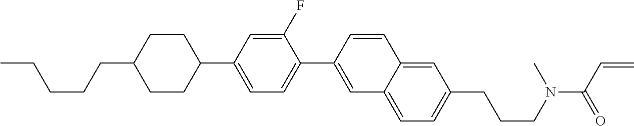 [SMILES: C=CC(=O)N(C)CCCc1ccc2cc(-c3ccc(C4CCC(CCCCC)CC4)cc3F)ccc2c1] |
| 1β-5-115 | 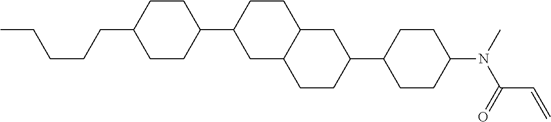 [SMILES: C=CC(=O)N(C)C1CCC(C2CCC3CC(C4CCC(CCCCC)CC4)CCC3C2)CC1] |
| 1β-5-116 | 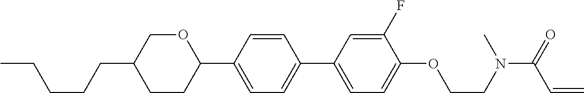 [SMILES: C=CC(=O)N(C)CCOc1ccc(-c2ccc(C3CCC(CCCCC)CO3)cc2)cc1F] |
| 1β-5-117 | 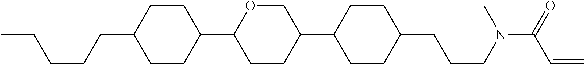 [SMILES: C=CC(=O)N(C)CCCC1CCC(C2CCC(C3CCC(CCCCC)CC3)OC2)CC1] |
| 1β-5-118 | 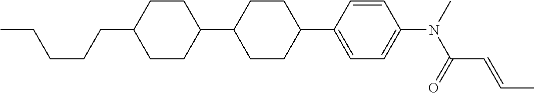 [SMILES: C/C=C/C(=O)N(C)c1ccc(C2CCC(C3CCC(CCCCC)CC3)CC2)cc1] |
| 1β-5-119 | 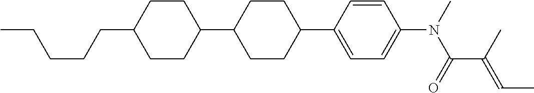 [SMILES: C/C=C(\C)C(=O)N(C)c1ccc(C2CCC(C3CCC(CCCCC)CC3)CC2)cc1] |
| 1β-5-120 | 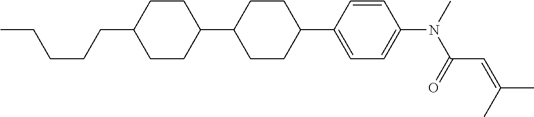 [SMILES: CCCCCC1CCC(C2CCC(c3ccc(N(C)C(=O)C=C(C)C)cc3)CC2)CC1] |
| 1β-5-121 | 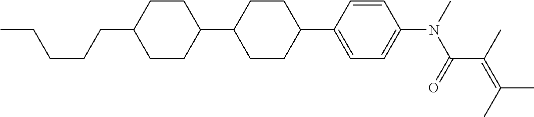 [SMILES: CCCCCC1CCC(C2CCC(c3ccc(N(C)C(=O)C(C)=C(C)C)cc3)CC2)CC1] |
| 1β-5-122 | 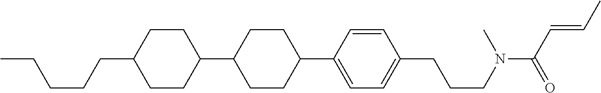 [SMILES: C/C=C/C(=O)N(C)CCCc1ccc(C2CCC(C3CCC(CCCCC)CC3)CC2)cc1] |
| 1β-5-123 | 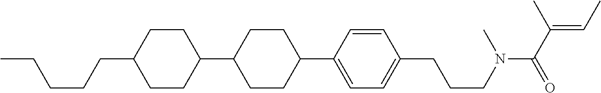 [SMILES: C/C=C(\C)C(=O)N(C)CCCc1ccc(C2CCC(C3CCC(CCCCC)CC3)CC2)cc1] |
| 1β-5-124 | 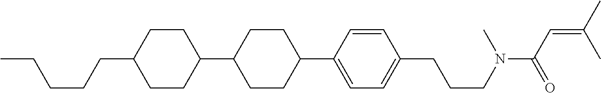 [SMILES: CCCCCC1CCC(C2CCC(c3ccc(CCCN(C)C(=O)C=C(C)C)cc3)CC2)CC1] |
| 1β-5-125 | 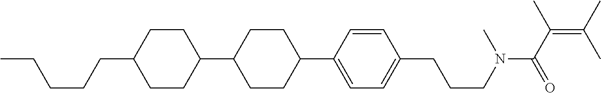 [SMILES: CCCCCC1CCC(C2CCC(c3ccc(CCCN(C)C(=O)C(C)=C(C)C)cc3)CC2)CC1] |
| 1β-5-126 | 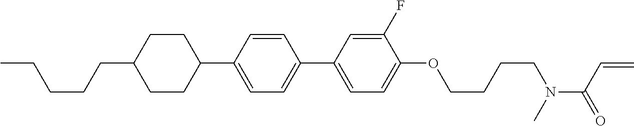 [SMILES: C=CC(=O)N(C)CCCCOc1ccc(-c2ccc(C3CCC(CCCCC)CC3)cc2)cc1F] |
| 1β-5-127 | 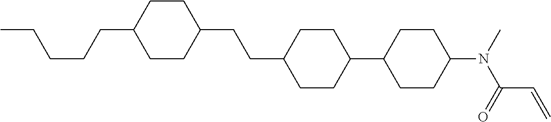 [SMILES: C=CC(=O)N(C)C1CCC(C2CCC(CCC3CCC(CCCCC)CC3)CC2)CC1] |
| 1β-5-128 | 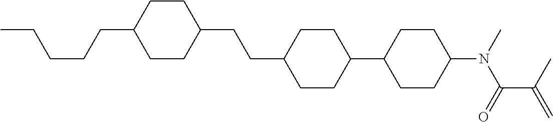 [SMILES: C=C(C)C(=O)N(C)C1CCC(C2CCC(CCC3CCC(CCCCC)CC3)CC2)CC1] |
| 1β-5-129 | 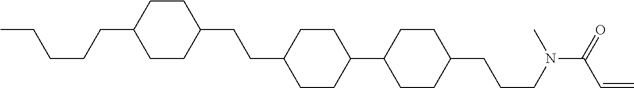 [SMILES: C=CC(=O)N(C)CCCC1CCC(C2CCC(CCC3CCC(CCCCC)CC3)CC2)CC1] |
| 1β-5-130 | 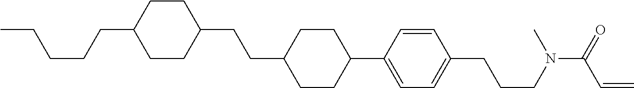 [SMILES: C=CC(=O)N(C)CCCc1ccc(C2CCC(CCC3CCC(CCCCC)CC3)CC2)cc1] |
| 1β-5-131 | 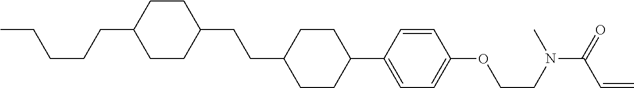 [SMILES: C=CC(=O)N(C)CCOc1ccc(C2CCC(CCC3CCC(CCCCC)CC3)CC2)cc1] |
| 1β-5-132 | 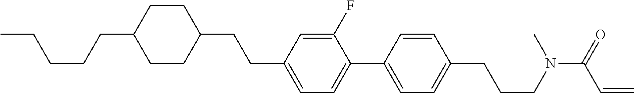 [SMILES: C=CC(=O)N(C)CCCc1ccc(-c2ccc(CCC3CCC(CCCCC)CC3)cc2F)cc1] |
| 1β-5-133 | 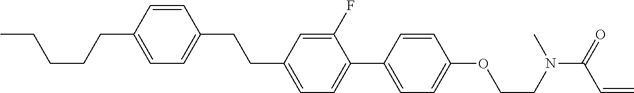 [SMILES: C=CC(=O)N(C)CCOc1ccc(-c2ccc(CCc3ccc(CCCCC)cc3)cc2F)cc1] |
| 1β-5-134 | 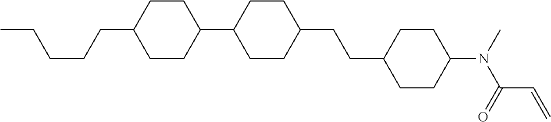 [SMILES: C=CC(=O)N(C)C1CCC(CCC2CCC(C3CCC(CCCCC)CC3)CC2)CC1] |
| 1β-5-135 | 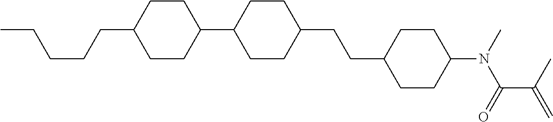 [SMILES: C=C(C)C(=O)N(C)C1CCC(CCC2CCC(C3CCC(CCCCC)CC3)CC2)CC1] |
| 1β-5-136 | 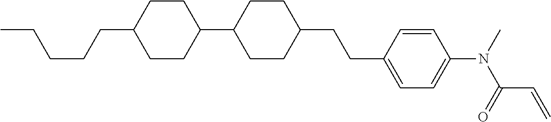 [SMILES: C=CC(=O)N(C)c1ccc(CCC2CCC(C3CCC(CCCCC)CC3)CC2)cc1] |
| 1β-5-137 | 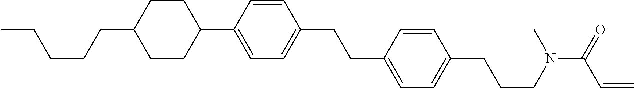 [SMILES: C=CC(=O)N(C)CCCc1ccc(CCc2ccc(C3CCC(CCCCC)CC3)cc2)cc1] |
| 1β-5-138 | 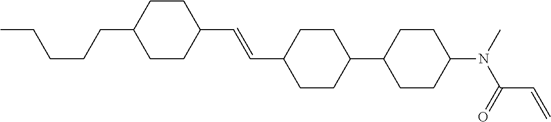 [SMILES: C=CC(=O)N(C)C1CCC(C2CCC(/C=C/C3CCC(CCCCC)CC3)CC2)CC1] |
| 1β-5-139 | 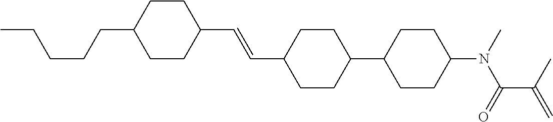 [SMILES: C=C(C)C(=O)N(C)C1CCC(C2CCC(/C=C/C3CCC(CCCCC)CC3)CC2)CC1] |
| 1β-5-140 | 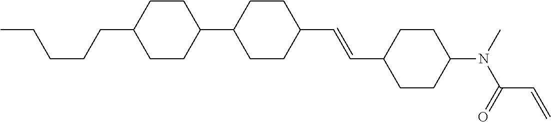 [SMILES: C=CC(=O)N(C)C1CCC(/C=C/C2CCC(C3CCC(CCCCC)CC3)CC2)CC1] |
| 1β-5-141 | 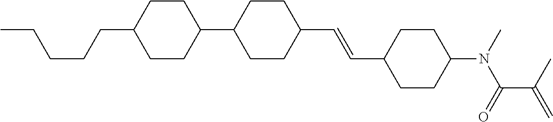 [SMILES: C=C(C)C(=O)N(C)C1CCC(/C=C/C2CCC(C3CCC(CCCCC)CC3)CC2)CC1] |
| 1β-5-142 | 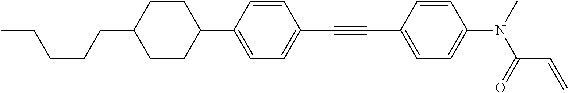 [SMILES: C=CC(=O)N(C)c1ccc(C#Cc2ccc(C3CCC(CCCCC)CC3)cc2)cc1] |
| 1β-5-143 | 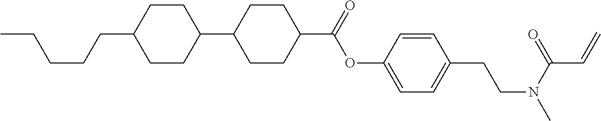 [SMILES: C=CC(=O)N(C)CCc1ccc(OC(=O)C2CCC(C3CCC(CCCCC)CC3)CC2)cc1] |
| 1β-5-144 | 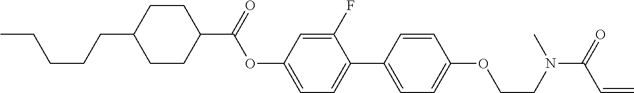 [SMILES: C=CC(=O)N(C)CCOc1ccc(-c2ccc(OC(=O)C3CCC(CCCCC)CC3)cc2F)cc1] |
| 1β-5-145 | 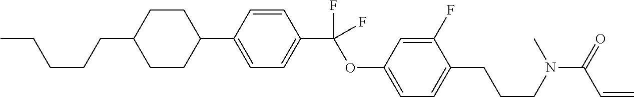 [SMILES: C=CC(=O)N(C)CCCc1ccc(OC(F)(F)c2ccc(C3CCC(CCCCC)CC3)cc2)cc1F] |
| 1β-5-146 | 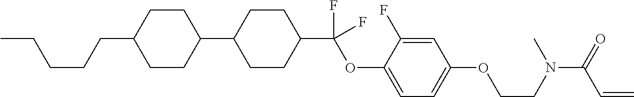 [SMILES: C=CC(=O)N(C)CCOc1ccc(OC(F)(F)C2CCC(C3CCC(CCCCC)CC3)CC2)c(F)c1] |
| 1β-5-147 | 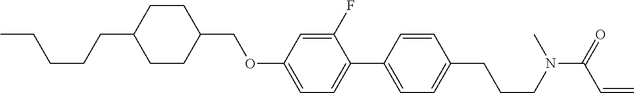 [SMILES: C=CC(=O)N(C)CCCc1ccc(-c2ccc(OCC3CCC(CCCCC)CC3)cc2F)cc1] |
| 1β-5-148 | 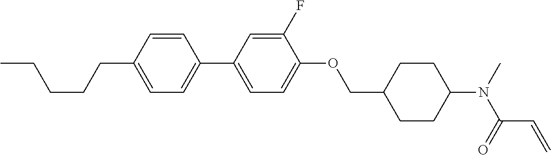 [SMILES: C=CC(=O)N(C)C1CCC(COc2ccc(-c3ccc(CCCCC)cc3)cc2F)CC1] |
| 1β-5-149 | 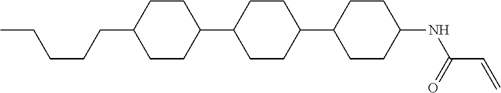 [SMILES: C=CC(=O)NC1CCC(C2CCC(C3CCC(CCCCC)CC3)CC2)CC1] |
| 1β-5-150 | 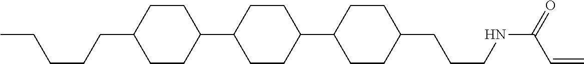 [SMILES: C=CC(=O)NCCCC1CCC(C2CCC(C3CCC(CCCCC)CC3)CC2)CC1] |
| 1β-5-151 | 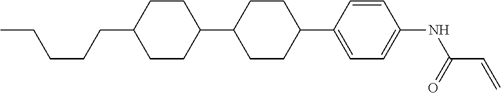 [SMILES: C=CC(=O)Nc1ccc(C2CCC(C3CCC(CCCCC)CC3)CC2)cc1] |
| 1β-5-152 | 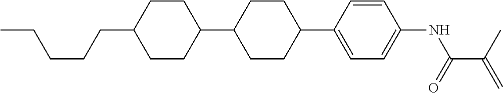 [SMILES: C=C(C)C(=O)Nc1ccc(C2CCC(C3CCC(CCCCC)CC3)CC2)cc1] |
| 1β-5-153 | 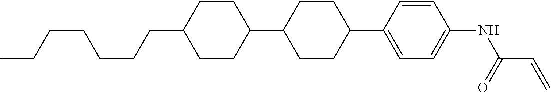 [SMILES: C=CC(=O)Nc1ccc(C2CCC(C3CCC(CCCCCCC)CC3)CC2)cc1] |
| 1β-5-154 | 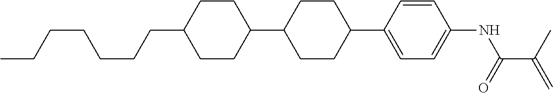 [SMILES: C=C(C)C(=O)Nc1ccc(C2CCC(C3CCC(CCCCCCC)CC3)CC2)cc1] |
| 1β-5-155 | 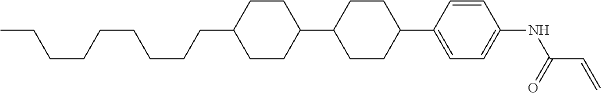 [SMILES: C=CC(=O)Nc1ccc(C2CCC(C3CCC(CCCCCCCCC)CC3)CC2)cc1] |
| 1β-5-156 | 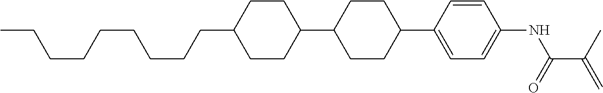 [SMILES: C=C(C)C(=O)Nc1ccc(C2CCC(C3CCC(CCCCCCCCC)CC3)CC2)cc1] |
| 1β-5-157 | 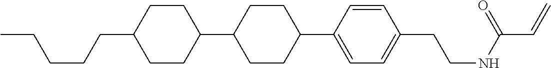 [SMILES: C=CC(=O)NCCc1ccc(C2CCC(C3CCC(CCCCC)CC3)CC2)cc1] |
| 1β-5-158 | 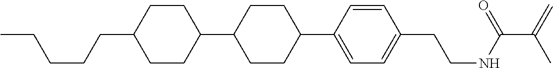 [SMILES: C=C(C)C(=O)NCCc1ccc(C2CCC(C3CCC(CCCCC)CC3)CC2)cc1] |
| 1β-5-159 | 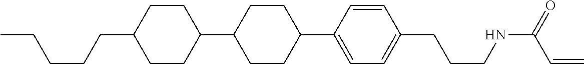 [SMILES: C=CC(=O)NCCCc1ccc(C2CCC(C3CCC(CCCCC)CC3)CC2)cc1] |
| 1β-5-160 | 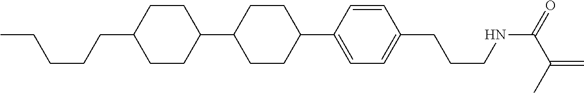 [SMILES: C=C(C)C(=O)NCCCc1ccc(C2CCC(C3CCC(CCCCC)CC3)CC2)cc1] |
| 1β-5-161 | 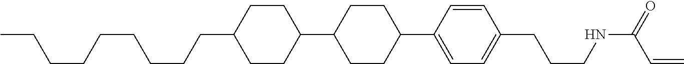 [SMILES: C=CC(=O)NCCCc1ccc(C2CCC(C3CCC(CCCCCCCCC)CC3)CC2)cc1] |
| 1β-5-162 | 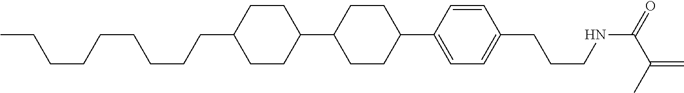 [SMILES: C=C(C)C(=O)NCCCc1ccc(C2CCC(C3CCC(CCCCCCCCC)CC3)CC2)cc1] |
| 1β-5-163 | 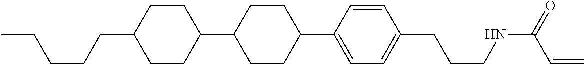 [SMILES: C=CC(=O)NCCCc1ccc(C2CCC(C3CCC(CCCCC)CC3)CC2)cc1] |
| 1β-5-164 | 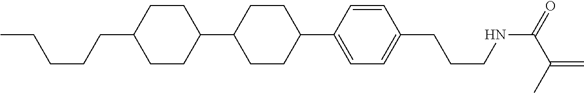 [SMILES: C=C(C)C(=O)NCCCc1ccc(C2CCC(C3CCC(CCCCC)CC3)CC2)cc1] |
| 1β-5-165 | 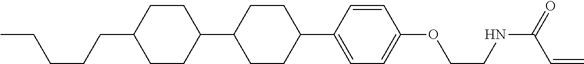 [SMILES: C=CC(=O)NCCOc1ccc(C2CCC(C3CCC(CCCCC)CC3)CC2)cc1] |
| 1β-5-166 | 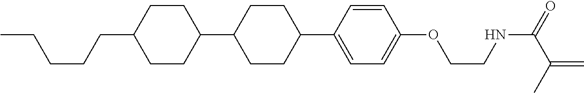 [SMILES: C=C(C)C(=O)NCCOc1ccc(C2CCC(C3CCC(CCCCC)CC3)CC2)cc1] |
| 1β-5-167 | 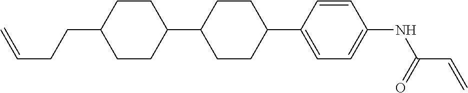 [SMILES: C=CCCC1CCC(C2CCC(c3ccc(NC(=O)C=C)cc3)CC2)CC1] |
| 1β-5-168 | 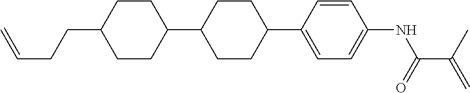 [SMILES: C=CCCC1CCC(C2CCC(c3ccc(NC(=O)C(=C)C)cc3)CC2)CC1] |
| 1β-5-169 | 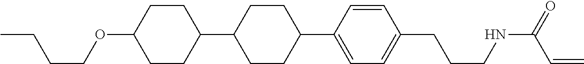 [SMILES: C=CC(=O)NCCCc1ccc(C2CCC(C3CCC(OCCCC)CC3)CC2)cc1] |
| 1β-5-170 | 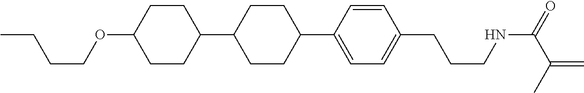 [SMILES: C=C(C)C(=O)NCCCc1ccc(C2CCC(C3CCC(OCCCC)CC3)CC2)cc1] |
| 1β-5-171 | 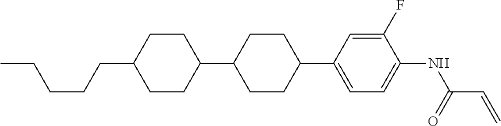 [SMILES: C=CC(=O)Nc1ccc(C2CCC(C3CCC(CCCCC)CC3)CC2)cc1F] |
| 1β-5-172 | 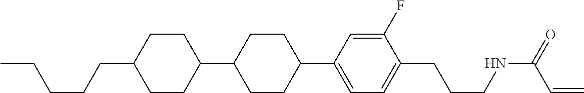 [SMILES: C=CC(=O)NCCCc1ccc(C2CCC(C3CCC(CCCCC)CC3)CC2)cc1F] |
| 1β-5-173 | 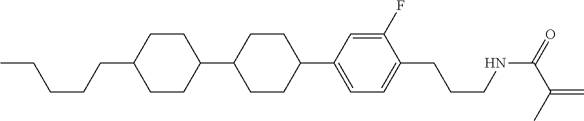 [SMILES: C=C(C)C(=O)NCCCc1ccc(C2CCC(C3CCC(CCCCC)CC3)CC2)cc1F] |
| 1β-5-174 | 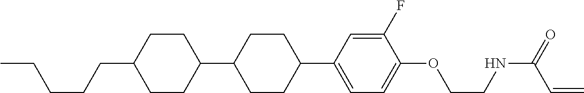 [SMILES: C=CC(=O)NCCOc1ccc(C2CCC(C3CCC(CCCCC)CC3)CC2)cc1F] |
| 1β-5-175 | 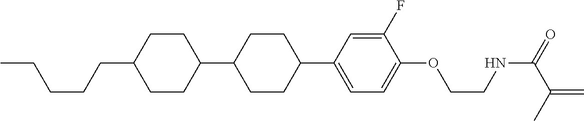 [SMILES: C=C(C)C(=O)NCCOc1ccc(C2CCC(C3CCC(CCCCC)CC3)CC2)cc1F] |
| 1β-5-176 | 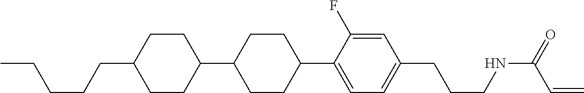 [SMILES: C=CC(=O)NCCCc1ccc(C2CCC(C3CCC(CCCCC)CC3)CC2)c(F)c1] |
| 1β-5-177 | 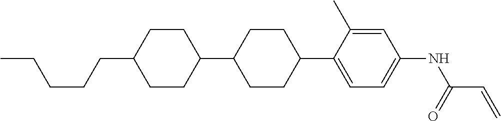 [SMILES: C=CC(=O)Nc1ccc(C2CCC(C3CCC(CCCCC)CC3)CC2)c(C)c1] |
| 1β-5-178 | 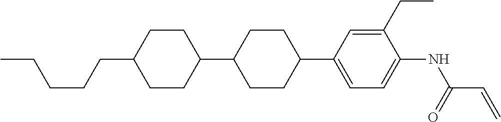 [SMILES: C=CC(=O)Nc1ccc(C2CCC(C3CCC(CCCCC)CC3)CC2)cc1CC] |
| 1β-5-179 | 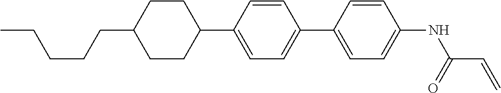 [SMILES: C=CC(=O)Nc1ccc(-c2ccc(C3CCC(CCCCC)CC3)cc2)cc1] |
| 1β-5-180 | 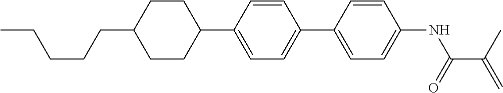 [SMILES: C=C(C)C(=O)Nc1ccc(-c2ccc(C3CCC(CCCCC)CC3)cc2)cc1] |
| 1β-5-181 | 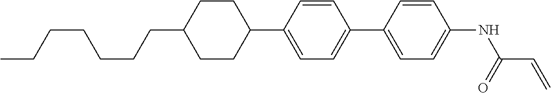 [SMILES: C=CC(=O)Nc1ccc(-c2ccc(C3CCC(CCCCCCC)CC3)cc2)cc1] |
| 1β-5-182 | 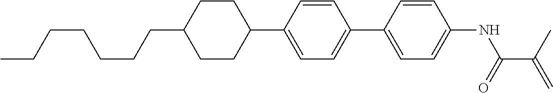 [SMILES: C=C(C)C(=O)Nc1ccc(-c2ccc(C3CCC(CCCCCCC)CC3)cc2)cc1] |
| 1β-5-183 | 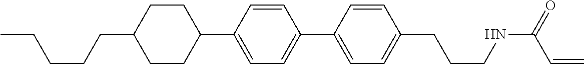 [SMILES: C=CC(=O)NCCCc1ccc(-c2ccc(C3CCC(CCCCC)CC3)cc2)cc1] |
| 1β-5-184 | 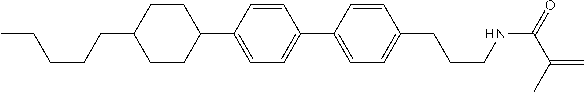 [SMILES: C=C(C)C(=O)NCCCc1ccc(-c2ccc(C3CCC(CCCCC)CC3)cc2)cc1] |
| 1β-5-185 | 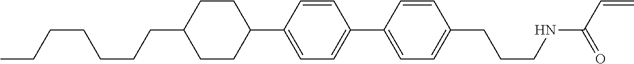 [SMILES: C=CC(=O)NCCCc1ccc(-c2ccc(C3CCC(CCCCCCC)CC3)cc2)cc1] |
| 1β-5-186 | 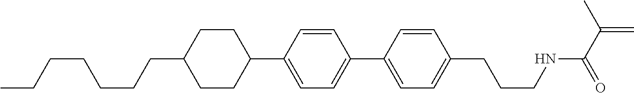 [SMILES: C=C(C)C(=O)NCCCc1ccc(-c2ccc(C3CCC(CCCCCCC)CC3)cc2)cc1] |
| 1β-5-187 | 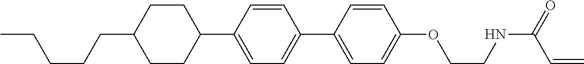 [SMILES: C=CC(=O)NCCOc1ccc(-c2ccc(C3CCC(CCCCC)CC3)cc2)cc1] |
| 1β-5-188 | 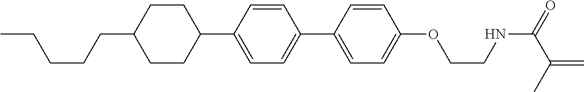 [SMILES: C=C(C)C(=O)NCCOc1ccc(-c2ccc(C3CCC(CCCCC)CC3)cc2)cc1] |
| 1β-5-189 | 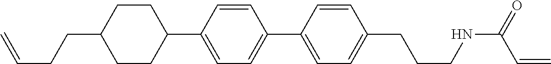 [SMILES: C=CCCC1CCC(c2ccc(-c3ccc(CCCNC(=O)C=C)cc3)cc2)CC1] |
| 1β-5-190 | 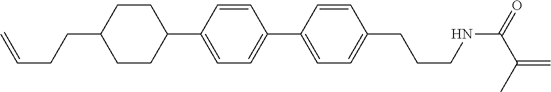 [SMILES: C=CCCC1CCC(c2ccc(-c3ccc(CCCNC(=O)C(=C)C)cc3)cc2)CC1] |
| 1β-5-191 | 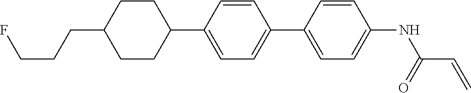 [SMILES: C=CC(=O)Nc1ccc(-c2ccc(C3CCC(CCCF)CC3)cc2)cc1] |
| 1β-5-192 | 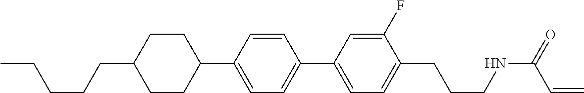 [SMILES: C=CC(=O)NCCCc1ccc(-c2ccc(C3CCC(CCCCC)CC3)cc2)cc1F] |
| 1β-5-193 | 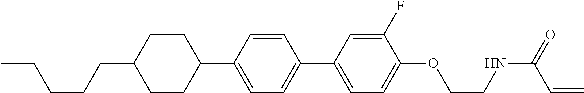 [SMILES: C=CC(=O)NCCOc1ccc(-c2ccc(C3CCC(CCCCC)CC3)cc2)cc1F] |
| 1β-5-194 | 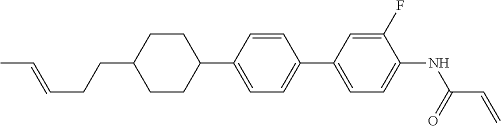 [SMILES: C=CC(=O)Nc1ccc(-c2ccc(C3CCC(CC/C=C/C)CC3)cc2)cc1F] |
| 1β-5-195 | 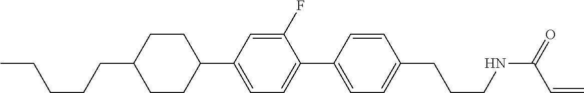 [SMILES: C=CC(=O)NCCCc1ccc(-c2ccc(C3CCC(CCCCC)CC3)cc2F)cc1] |
| 1β-5-196 | 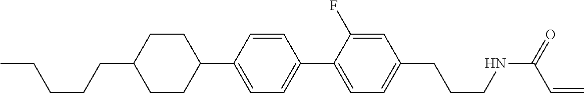 [SMILES: C=CC(=O)NCCCc1ccc(-c2ccc(C3CCC(CCCCC)CC3)cc2)c(F)c1] |
| 1β-5-197 | 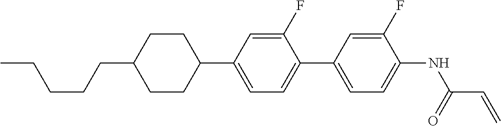 [SMILES: C=CC(=O)Nc1ccc(-c2ccc(C3CCC(CCCCC)CC3)cc2F)cc1F] |
| 1β-5-198 | 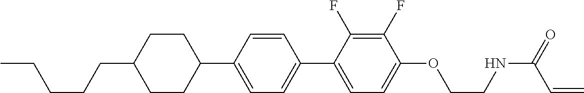 [SMILES: C=CC(=O)NCCOc1ccc(-c2ccc(C3CCC(CCCCC)CC3)cc2)c(F)c1F] |
| 1β-5-199 | 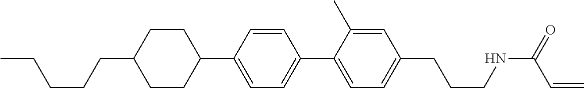 [SMILES: C=CC(=O)NCCCc1ccc(-c2ccc(C3CCC(CCCCC)CC3)cc2)c(C)c1] |
| 1β-5-200 | 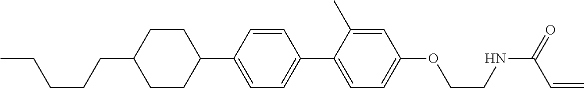 [SMILES: C=CC(=O)NCCOc1ccc(-c2ccc(C3CCC(CCCCC)CC3)cc2)c(C)c1] |
| 1β-5-201 | 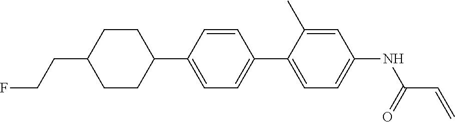 [SMILES: C=CC(=O)Nc1ccc(-c2ccc(C3CCC(CCF)CC3)cc2)c(C)c1] |
| 1β-5-202 | 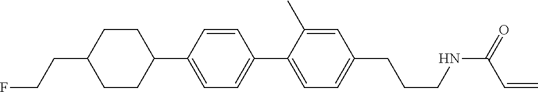 [SMILES: C=CC(=O)NCCCc1ccc(-c2ccc(C3CCC(CCF)CC3)cc2)c(C)c1] |
| 1β-5-203 | 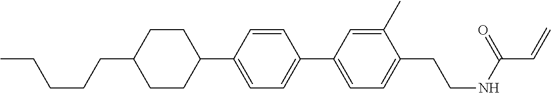 [SMILES: C=CC(=O)NCCc1ccc(-c2ccc(C3CCC(CCCCC)CC3)cc2)cc1C] |
| 1β-5-204 | 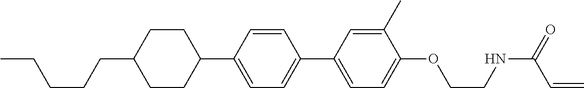 [SMILES: C=CC(=O)NCCOc1ccc(-c2ccc(C3CCC(CCCCC)CC3)cc2)cc1C] |
| 1β-5-205 | 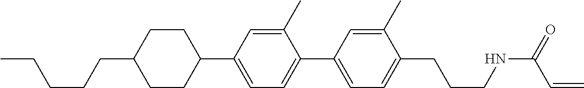 [SMILES: C=CC(=O)NCCCc1ccc(-c2ccc(C3CCC(CCCCC)CC3)cc2C)cc1C] |
| 1β-5-206 | 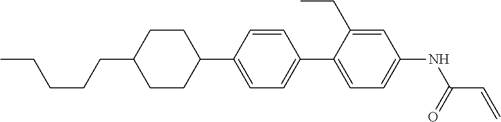 [SMILES: C=CC(=O)Nc1ccc(-c2ccc(C3CCC(CCCCC)CC3)cc2)c(CC)c1] |
| 1β-5-207 | 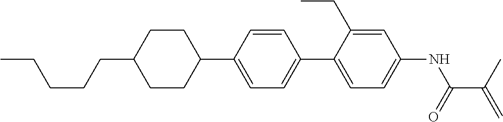 [SMILES: C=C(C)C(=O)Nc1ccc(-c2ccc(C3CCC(CCCCC)CC3)cc2)c(CC)c1] |
| 1β-5-208 | 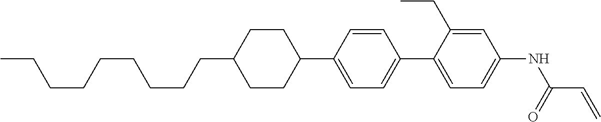 [SMILES: C=CC(=O)Nc1ccc(-c2ccc(C3CCC(CCCCCCCCC)CC3)cc2)c(CC)c1] |
| 1β-5-209 | 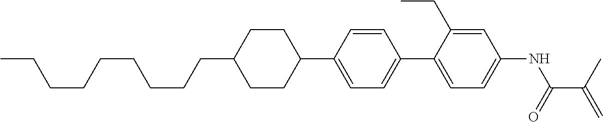 [SMILES: C=C(C)C(=O)Nc1ccc(-c2ccc(C3CCC(CCCCCCCCC)CC3)cc2)c(CC)c1] |
| 1β-5-210 | 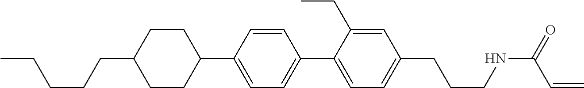 [SMILES: C=CC(=O)NCCCc1ccc(-c2ccc(C3CCC(CCCCC)CC3)cc2)c(CC)c1] |
| 1β-5-211 | 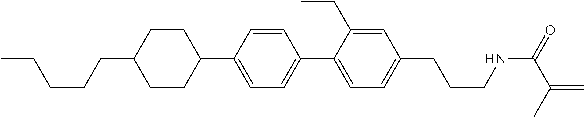 [SMILES: C=C(C)C(=O)NCCCc1ccc(-c2ccc(C3CCC(CCCCC)CC3)cc2)c(CC)c1] |
| 1β-5-212 | 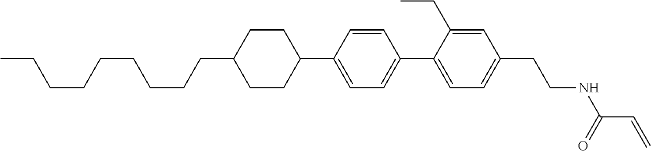 [SMILES: C=CC(=O)NCCc1ccc(-c2ccc(C3CCC(CCCCCCCCC)CC3)cc2)c(CC)c1] |
| 1β-5-213 | 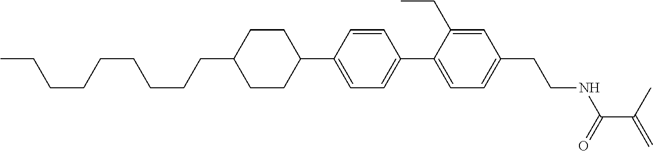 [SMILES: C=C(C)C(=O)NCCc1ccc(-c2ccc(C3CCC(CCCCCCCCC)CC3)cc2)c(CC)c1] |
| 1β-5-214 | 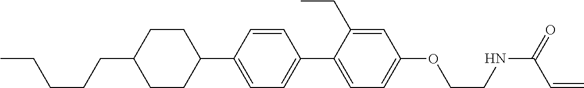 [SMILES: C=CC(=O)NCCOc1ccc(-c2ccc(C3CCC(CCCCC)CC3)cc2)c(CC)c1] |
| 1β-5-215 | 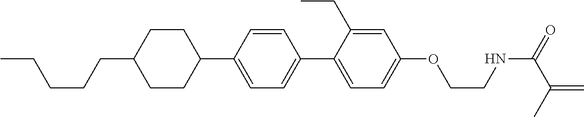 [SMILES: C=C(C)C(=O)NCCOc1ccc(-c2ccc(C3CCC(CCCCC)CC3)cc2)c(CC)c1] |
| 1β-5-216 | 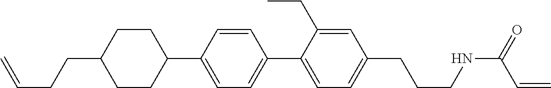 [SMILES: C=CCCC1CCC(c2ccc(-c3ccc(CCCNC(=O)C=C)cc3CC)cc2)CC1] |
| 1β-5-217 | 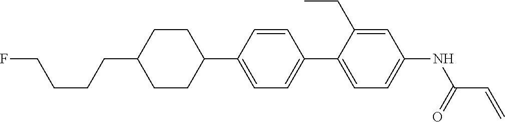 [SMILES: C=CC(=O)Nc1ccc(-c2ccc(C3CCC(CCCCF)CC3)cc2)c(CC)c1] |
| 1β-5-218 | 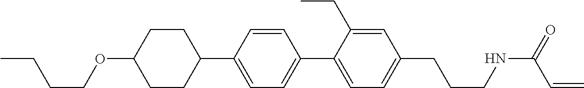 [SMILES: C=CC(=O)NCCCc1ccc(-c2ccc(C3CCC(OCCCC)CC3)cc2)c(CC)c1] |
| 1β-5-219 | 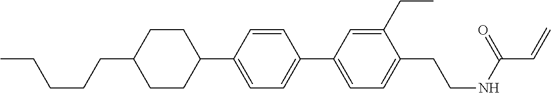 [SMILES: C=CC(=O)NCCc1ccc(-c2ccc(C3CCC(CCCCC)CC3)cc2)cc1CC] |
| 1β-5-220 | 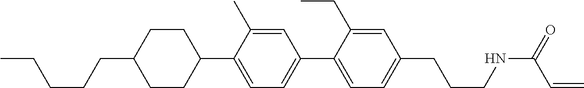 [SMILES: C=CC(=O)NCCCc1ccc(-c2ccc(C3CCC(CCCCC)CC3)c(C)c2)c(CC)c1] |
| 1β-5-221 | 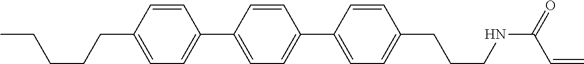 [SMILES: C=CC(=O)NCCCc1ccc(-c2ccc(-c3ccc(CCCCC)cc3)cc2)cc1] |
| 1β-5-222 | 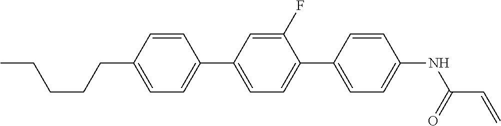 [SMILES: C=CC(=O)Nc1ccc(-c2ccc(-c3ccc(CCCCC)cc3)cc2F)cc1] |
| 1β-5-223 | 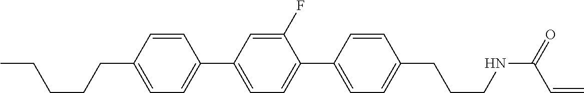 [SMILES: C=CC(=O)NCCCc1ccc(-c2ccc(-c3ccc(CCCCC)cc3)cc2F)cc1] |
| 1β-5-224 | 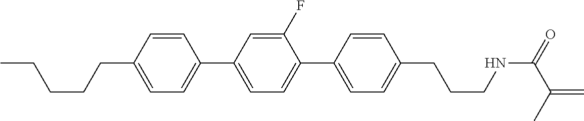 [SMILES: C=C(C)C(=O)NCCCc1ccc(-c2ccc(-c3ccc(CCCCC)cc3)cc2F)cc1] |
| 1β-5-225 | 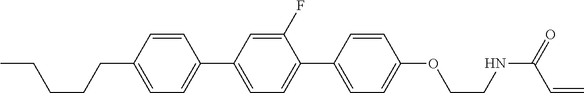 [SMILES: C=CC(=O)NCCOc1ccc(-c2ccc(-c3ccc(CCCCC)cc3)cc2F)cc1] |
| 1β-5-226 | 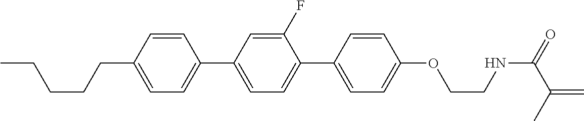 [SMILES: C=C(C)C(=O)NCCOc1ccc(-c2ccc(-c3ccc(CCCCC)cc3)cc2F)cc1] |
| 1β-5-227 | 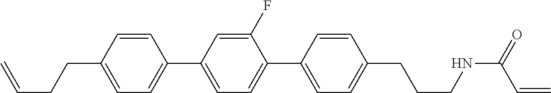 [SMILES: C=CCCc1ccc(-c2ccc(-c3ccc(CCCNC(=O)C=C)cc3)c(F)c2)cc1] |
| 1β-5-228 | 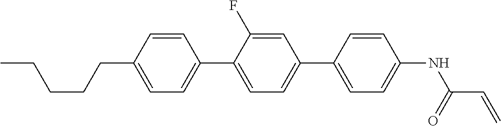 [SMILES: C=CC(=O)Nc1ccc(-c2ccc(-c3ccc(CCCCC)cc3)c(F)c2)cc1] |
| 1β-5-229 | 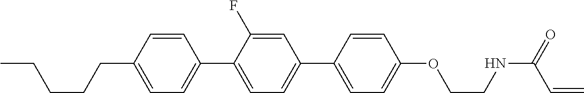 [SMILES: C=CC(=O)NCCOc1ccc(-c2ccc(-c3ccc(CCCCC)cc3)c(F)c2)cc1] |
| 1β-5-230 | 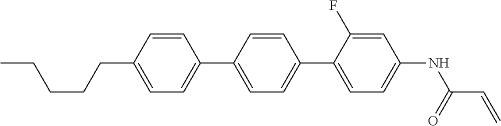 [SMILES: C=CC(=O)Nc1ccc(-c2ccc(-c3ccc(CCCCC)cc3)cc2)c(F)c1] |
| 1β-5-231 | 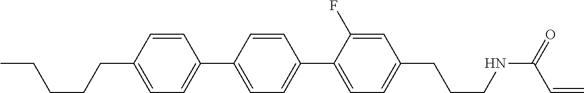 [SMILES: C=CC(=O)NCCCc1ccc(-c2ccc(-c3ccc(CCCCC)cc3)cc2)c(F)c1] |
| 1β-5-232 | 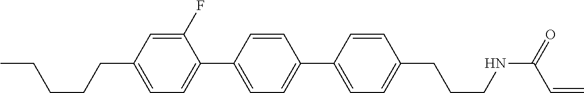 [SMILES: C=CC(=O)NCCCc1ccc(-c2ccc(-c3ccc(CCCCC)cc3F)cc2)cc1] |
| 1β-5-233 | 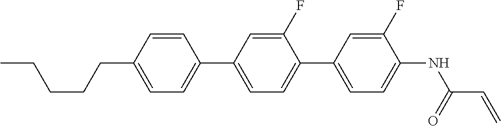 [SMILES: C=CC(=O)Nc1ccc(-c2ccc(-c3ccc(CCCCC)cc3)cc2F)cc1F] |
| 1β-5-234 | 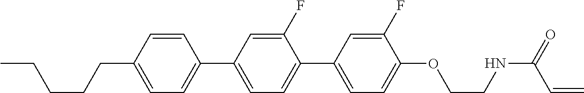 [SMILES: C=CC(=O)NCCOc1ccc(-c2ccc(-c3ccc(CCCCC)cc3)cc2F)cc1F] |
| 1β-5-235 | 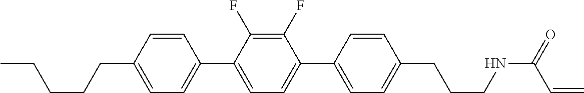 [SMILES: C=CC(=O)NCCCc1ccc(-c2ccc(-c3ccc(CCCCC)cc3)c(F)c2F)cc1] |
| 1β-5-236 | 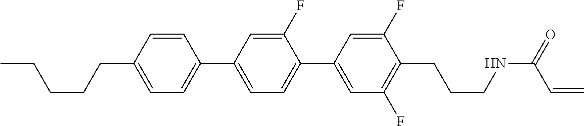 [SMILES: C=CC(=O)NCCCc1c(F)cc(-c2ccc(-c3ccc(CCCCC)cc3)cc2F)cc1F] |
| 1β-5-237 | 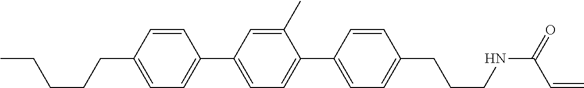 [SMILES: C=CC(=O)NCCCc1ccc(-c2ccc(-c3ccc(CCCCC)cc3)cc2C)cc1] |
| 1β-5-238 | 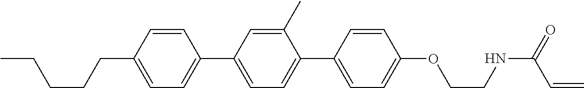 [SMILES: C=CC(=O)NCCOc1ccc(-c2ccc(-c3ccc(CCCCC)cc3)cc2C)cc1] |
| 1β-5-239 | 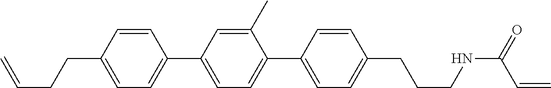 [SMILES: C=CCCc1ccc(-c2ccc(-c3ccc(CCCNC(=O)C=C)cc3)c(C)c2)cc1] |
| 1β-5-240 | 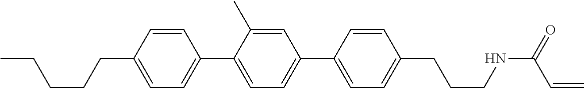 [SMILES: C=CC(=O)NCCCc1ccc(-c2ccc(-c3ccc(CCCCC)cc3)c(C)c2)cc1] |
| 1β-5-241 | 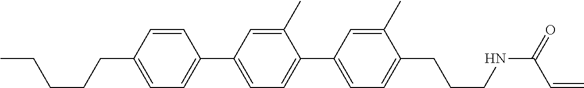 [SMILES: C=CC(=O)NCCCc1ccc(-c2ccc(-c3ccc(CCCCC)cc3)cc2C)cc1C] |
| 1β-5-242 | 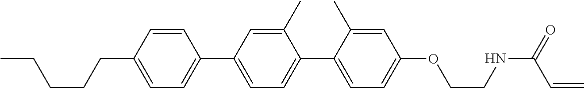 [SMILES: C=CC(=O)NCCOc1ccc(-c2ccc(-c3ccc(CCCCC)cc3)cc2C)c(C)c1] |
| 1β-5-243 | 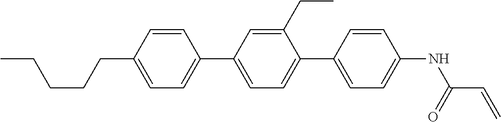 [SMILES: C=CC(=O)Nc1ccc(-c2ccc(-c3ccc(CCCCC)cc3)cc2CC)cc1] |
| 1β-5-244 | 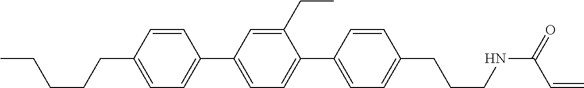 [SMILES: C=CC(=O)NCCCc1ccc(-c2ccc(-c3ccc(CCCCC)cc3)cc2CC)cc1] |
| 1β-5-245 | 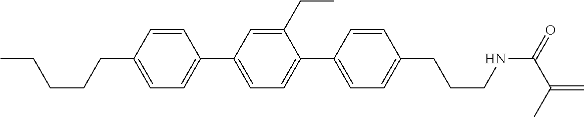 [SMILES: C=C(C)C(=O)NCCCc1ccc(-c2ccc(-c3ccc(CCCCC)cc3)cc2CC)cc1] |
| 1β-5-246 | 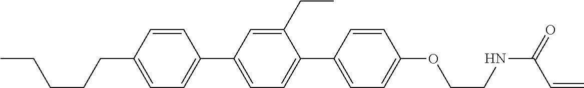 [SMILES: C=CC(=O)NCCOc1ccc(-c2ccc(-c3ccc(CCCCC)cc3)cc2CC)cc1] |
| 1β-5-247 | 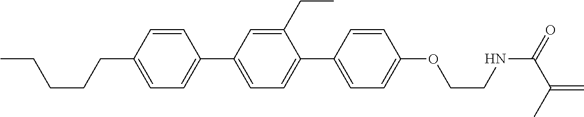 [SMILES: C=C(C)C(=O)NCCOc1ccc(-c2ccc(-c3ccc(CCCCC)cc3)cc2CC)cc1] |
| 1β-5-248 | 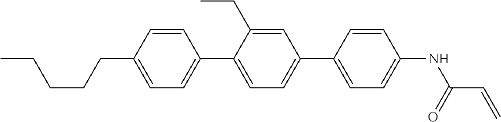 [SMILES: C=CC(=O)Nc1ccc(-c2ccc(-c3ccc(CCCCC)cc3)c(CC)c2)cc1] |
| 1β-5-249 | 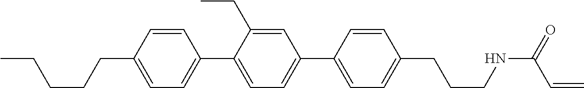 [SMILES: C=CC(=O)NCCCc1ccc(-c2ccc(-c3ccc(CCCCC)cc3)c(CC)c2)cc1] |
| 1β-5-250 | 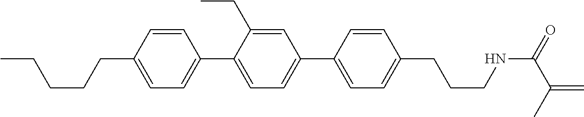 [SMILES: C=C(C)C(=O)NCCCc1ccc(-c2ccc(-c3ccc(CCCCC)cc3)c(CC)c2)cc1] |
| 1β-5-251 | 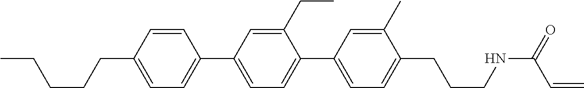 [SMILES: C=CC(=O)NCCCc1ccc(-c2ccc(-c3ccc(CCCCC)cc3)cc2CC)cc1C] |
| 1β-5-252 | 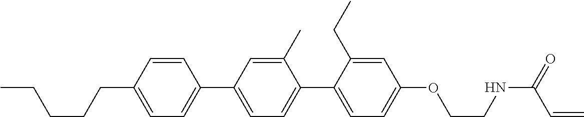 [SMILES: C=CC(=O)NCCOc1ccc(-c2ccc(-c3ccc(CCCCC)cc3)cc2C)c(CC)c1] |
| 1β-5-253 | 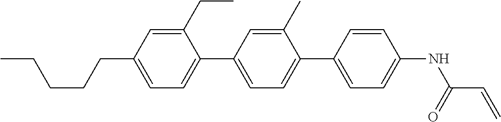 [SMILES: C=CC(=O)Nc1ccc(-c2ccc(-c3ccc(CCCCC)cc3CC)cc2C)cc1] |
| 1β-5-254 | 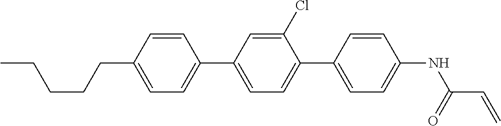 [SMILES: C=CC(=O)Nc1ccc(-c2ccc(-c3ccc(CCCCC)cc3)cc2Cl)cc1] |
| 1β-5-255 | 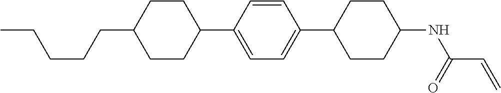 [SMILES: C=CC(=O)NC1CCC(c2ccc(C3CCC(CCCCC)CC3)cc2)CC1] |
| 1β-5-256 | 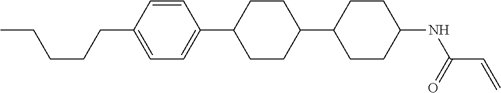 [SMILES: C=CC(=O)NC1CCC(C2CCC(c3ccc(CCCCC)cc3)CC2)CC1] |
| 1β-5-257 | 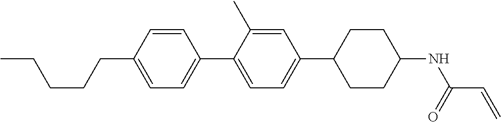 [SMILES: C=CC(=O)NC1CCC(c2ccc(-c3ccc(CCCCC)cc3)c(C)c2)CC1] |
| 1β-5-258 | 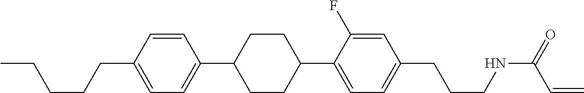 [SMILES: C=CC(=O)NCCCc1ccc(C2CCC(c3ccc(CCCCC)cc3)CC2)c(F)c1] |
| 1β-5-259 | 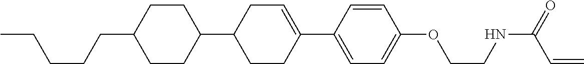 [SMILES: C=CC(=O)NCCOc1ccc(C2=CCC(C3CCC(CCCCC)CC3)CC2)cc1] |
| 1β-5-260 | 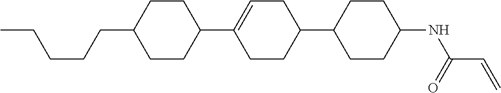 [SMILES: C=CC(=O)NC1CCC(C2CC=C(C3CCC(CCCCC)CC3)CC2)CC1] |
| 1β-5-261 | 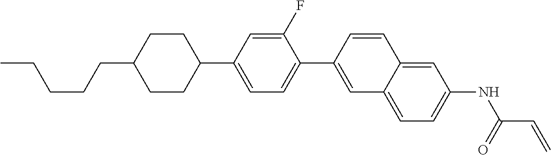 [SMILES: C=CC(=O)Nc1ccc2cc(-c3ccc(C4CCC(CCCCC)CC4)cc3F)ccc2c1] |
| 1β-5-262 | 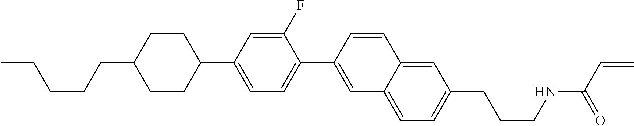 [SMILES: C=CC(=O)NCCCc1ccc2cc(-c3ccc(C4CCC(CCCCC)CC4)cc3F)ccc2c1] |
| 1β-5-263 | 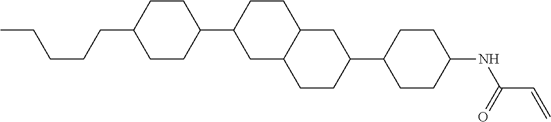 [SMILES: C=CC(=O)NC1CCC(C2CCC3CC(C4CCC(CCCCC)CC4)CCC3C2)CC1] |
| 1β-5-264 | 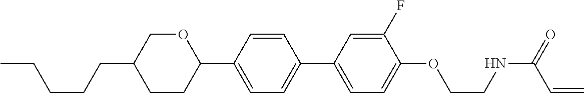 [SMILES: C=CC(=O)NCCOc1ccc(-c2ccc(C3CCC(CCCCC)CO3)cc2)cc1F] |
| 1β-5-265 | 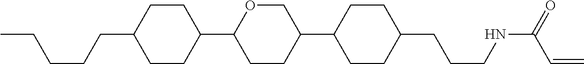 [SMILES: C=CC(=O)NCCCC1CCC(C2CCC(C3CCC(CCCCC)CC3)OC2)CC1] |
| 1β-5-266 | 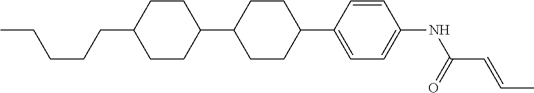 [SMILES: C/C=C/C(=O)Nc1ccc(C2CCC(C3CCC(CCCCC)CC3)CC2)cc1] |
| 1β-5-267 | 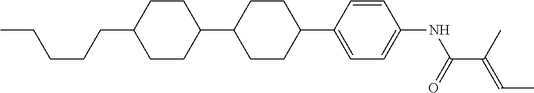 [SMILES: C/C=C(\C)C(=O)Nc1ccc(C2CCC(C3CCC(CCCCC)CC3)CC2)cc1] |
| 1β-5-268 | 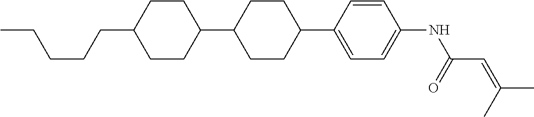 [SMILES: CCCCCC1CCC(C2CCC(c3ccc(NC(=O)C=C(C)C)cc3)CC2)CC1] |
| 1β-5-269 | 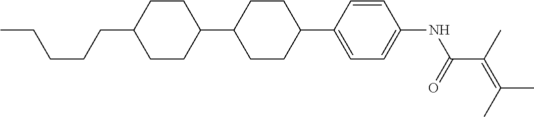 [SMILES: CCCCCC1CCC(C2CCC(c3ccc(NC(=O)C(C)=C(C)C)cc3)CC2)CC1] |
| 1β-5-270 | 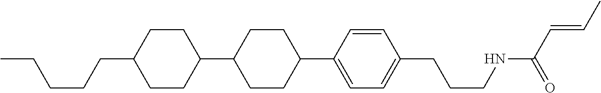 [SMILES: C/C=C/C(=O)NCCCc1ccc(C2CCC(C3CCC(CCCCC)CC3)CC2)cc1] |
| 1β-5-271 | 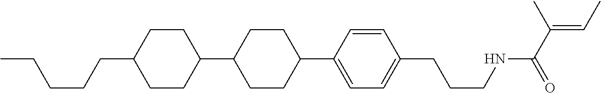 [SMILES: C/C=C(\C)C(=O)NCCCc1ccc(C2CCC(C3CCC(CCCCC)CC3)CC2)cc1] |
| 1β-5-272 | 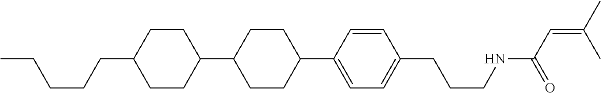 [SMILES: CCCCCC1CCC(C2CCC(c3ccc(CCCNC(=O)C=C(C)C)cc3)CC2)CC1] |
| 1β-5-273 | 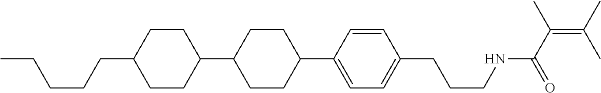 [SMILES: CCCCCC1CCC(C2CCC(c3ccc(CCCNC(=O)C(C)=C(C)C)cc3)CC2)CC1] |
| 1β-5-274 | 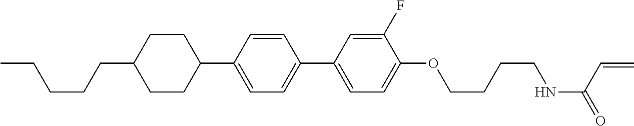 [SMILES: C=CC(=O)NCCCCOc1ccc(-c2ccc(C3CCC(CCCCC)CC3)cc2)cc1F] |
| 1β-5-275 | 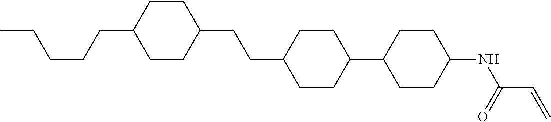 [SMILES: C=CC(=O)NC1CCC(C2CCC(CCC3CCC(CCCCC)CC3)CC2)CC1] |
| 1β-5-276 | 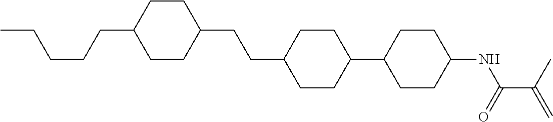 [SMILES: C=C(C)C(=O)NC1CCC(C2CCC(CCC3CCC(CCCCC)CC3)CC2)CC1] |
| 1β-5-277 | 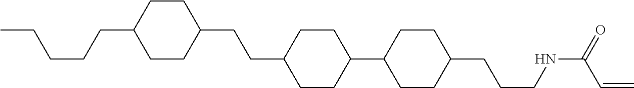 [SMILES: C=CC(=O)NCCCC1CCC(C2CCC(CCC3CCC(CCCCC)CC3)CC2)CC1] |
| 1β-5-278 | 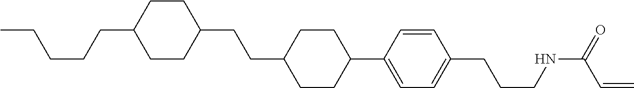 [SMILES: C=CC(=O)NCCCc1ccc(C2CCC(CCC3CCC(CCCCC)CC3)CC2)cc1] |
| 1β-5-279 | 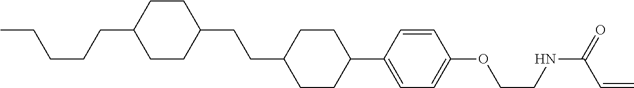 [SMILES: C=CC(=O)NCCOc1ccc(C2CCC(CCC3CCC(CCCCC)CC3)CC2)cc1] |
| 1β-5-280 | 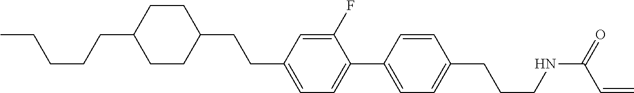 [SMILES: C=CC(=O)NCCCc1ccc(-c2ccc(CCC3CCC(CCCCC)CC3)cc2F)cc1] |
| 1β-5-281 | 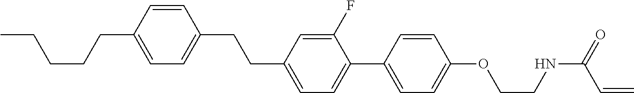 [SMILES: C=CC(=O)NCCOc1ccc(-c2ccc(CCc3ccc(CCCCC)cc3)cc2F)cc1] |
| 1β-5-282 | 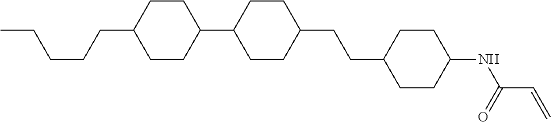 [SMILES: C=CC(=O)NC1CCC(CCC2CCC(C3CCC(CCCCC)CC3)CC2)CC1] |
| 1β-5-283 | 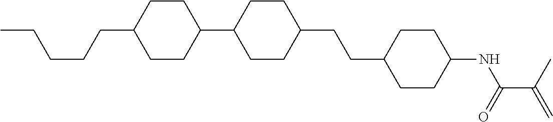 [SMILES: C=C(C)C(=O)NC1CCC(CCC2CCC(C3CCC(CCCCC)CC3)CC2)CC1] |
| 1β-5-284 | 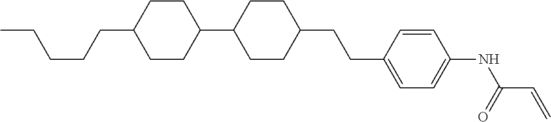 [SMILES: C=CC(=O)Nc1ccc(CCC2CCC(C3CCC(CCCCC)CC3)CC2)cc1] |
| 1β-5-285 | 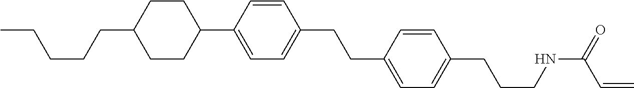 [SMILES: C=CC(=O)NCCCc1ccc(CCc2ccc(C3CCC(CCCCC)CC3)cc2)cc1] |
| 1β-5-286 | 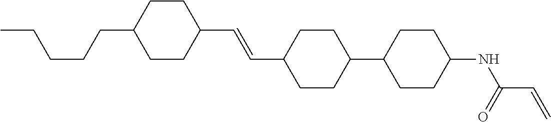 [SMILES: C=CC(=O)NC1CCC(C2CCC(/C=C/C3CCC(CCCCC)CC3)CC2)CC1] |
| 1β-5-287 | 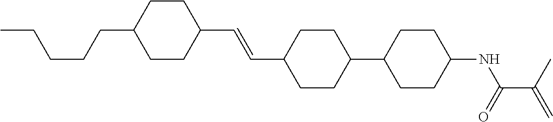 [SMILES: C=C(C)C(=O)NC1CCC(C2CCC(/C=C/C3CCC(CCCCC)CC3)CC2)CC1] |
| 1β-5-288 | 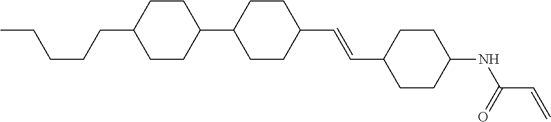 [SMILES: C=CC(=O)NC1CCC(/C=C/C2CCC(C3CCC(CCCCC)CC3)CC2)CC1] |
| 1β-5-289 | 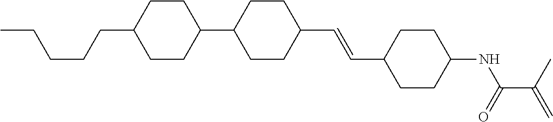 [SMILES: C=C(C)C(=O)NC1CCC(/C=C/C2CCC(C3CCC(CCCCC)CC3)CC2)CC1] |
| 1β-5-290 | 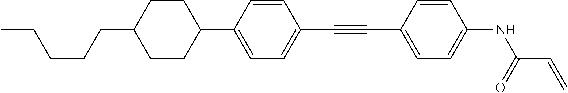 [SMILES: C=CC(=O)Nc1ccc(C#Cc2ccc(C3CCC(CCCCC)CC3)cc2)cc1] |
| 1β-5-291 | 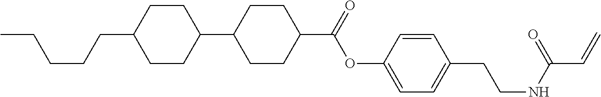 [SMILES: C=CC(=O)NCCc1ccc(OC(=O)C2CCC(C3CCC(CCCCC)CC3)CC2)cc1] |
| 1β-5-292 | 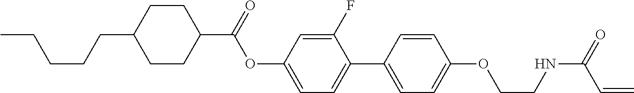 [SMILES: C=CC(=O)NCCOc1ccc(-c2ccc(OC(=O)C3CCC(CCCCC)CC3)cc2F)cc1] |
| 1β-5-293 | 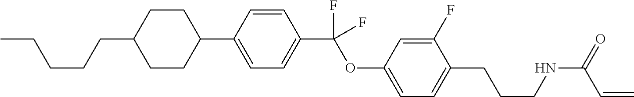 [SMILES: C=CC(=O)NCCCc1ccc(OC(F)(F)c2ccc(C3CCC(CCCCC)CC3)cc2)cc1F] |
| 1β-5-294 | 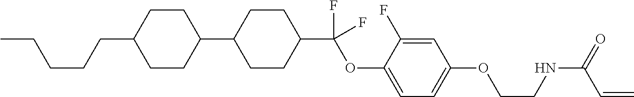 [SMILES: C=CC(=O)NCCOc1ccc(OC(F)(F)C2CCC(C3CCC(CCCCC)CC3)CC2)c(F)c1] |
| 1β-5-295 | 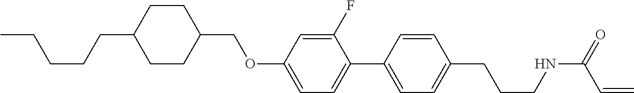 [SMILES: C=CC(=O)NCCCc1ccc(-c2ccc(OCC3CCC(CCCCC)CC3)cc2F)cc1] |
| 1β-5-296 | 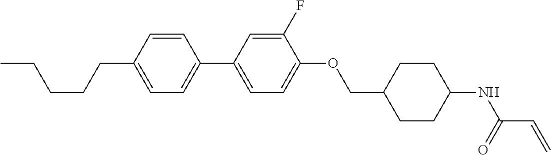 [SMILES: C=CC(=O)NC1CCC(COc2ccc(-c3ccc(CCCCC)cc3)cc2F)CC1] |
| 1β-6-1 | 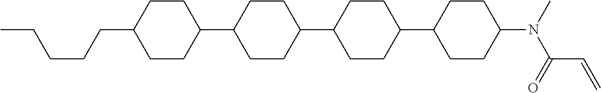 [SMILES: C=CC(=O)N(C)C1CCC(C2CCC(C3CCC(C4CCC(CCCCC)CC4)CC3)CC2)CC1] |
| 1β-6-2 | 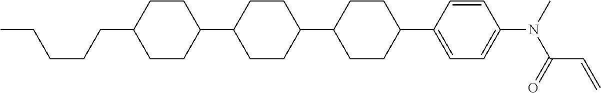 [SMILES: C=CC(=O)N(C)c1ccc(C2CCC(C3CCC(C4CCC(CCCCC)CC4)CC3)CC2)cc1] |
| 1β-6-3 | 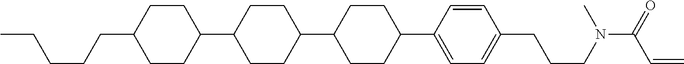 [SMILES: C=CC(=O)N(C)CCCc1ccc(C2CCC(C3CCC(C4CCC(CCCCC)CC4)CC3)CC2)cc1] |
| 1β-6-4 | 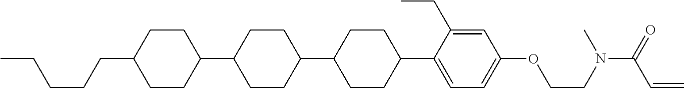 [SMILES: C=CC(=O)N(C)CCOc1ccc(C2CCC(C3CCC(C4CCC(CCCCC)CC4)CC3)CC2)c(CC)c1] |
| 1β-6-5 | 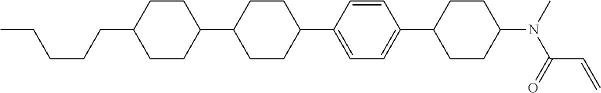 [SMILES: C=CC(=O)N(C)C1CCC(c2ccc(C3CCC(C4CCC(CCCCC)CC4)CC3)cc2)CC1] |
| 1β-6-6 | 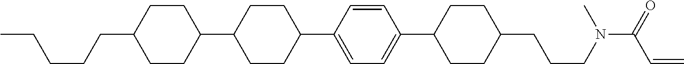 [SMILES: C=CC(=O)N(C)CCCC1CCC(c2ccc(C3CCC(C4CCC(CCCCC)CC4)CC3)cc2)CC1] |
| 1β-6-7 | 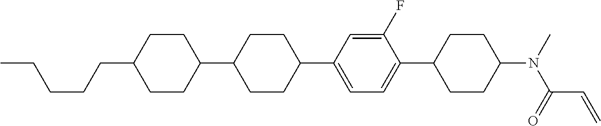 [SMILES: C=CC(=O)N(C)C1CCC(c2ccc(C3CCC(C4CCC(CCCCC)CC4)CC3)cc2F)CC1] |
| 1β-6-8 | 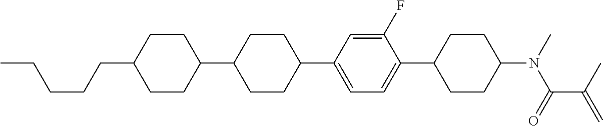 [SMILES: C=C(C)C(=O)N(C)C1CCC(c2ccc(C3CCC(C4CCC(CCCCC)CC4)CC3)cc2F)CC1] |
| 1β-6-9 | 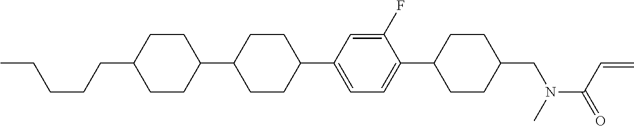 [SMILES: C=CC(=O)N(C)CC1CCC(c2ccc(C3CCC(C4CCC(CCCCC)CC4)CC3)cc2F)CC1] |
| 1β-6-10 | 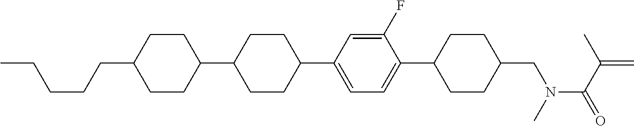 [SMILES: C=C(C)C(=O)N(C)CC1CCC(c2ccc(C3CCC(C4CCC(CCCCC)CC4)CC3)cc2F)CC1] |
| 1β-6-11 | 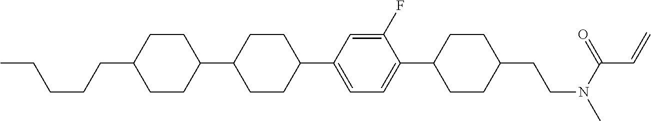 [SMILES: C=CC(=O)N(C)CCC1CCC(c2ccc(C3CCC(C4CCC(CCCCC)CC4)CC3)cc2F)CC1] |
| 1β-6-12 | 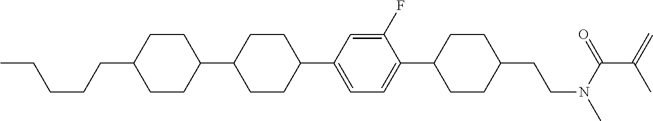 [SMILES: C=C(C)C(=O)N(C)CCC1CCC(c2ccc(C3CCC(C4CCC(CCCCC)CC4)CC3)cc2F)CC1] |
| 1β-6-13 | 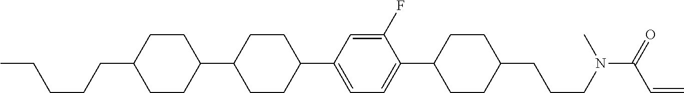 [SMILES: C=CC(=O)N(C)CCCC1CCC(c2ccc(C3CCC(C4CCC(CCCCC)CC4)CC3)cc2F)CC1] |
| 1β-6-14 | 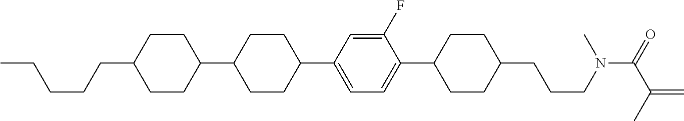 [SMILES: C=C(C)C(=O)N(C)CCCC1CCC(c2ccc(C3CCC(C4CCC(CCCCC)CC4)CC3)cc2F)CC1] |
| 1β-6-15 | 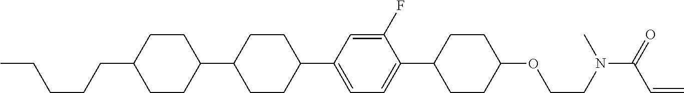 [SMILES: C=CC(=O)N(C)CCOC1CCC(c2ccc(C3CCC(C4CCC(CCCCC)CC4)CC3)cc2F)CC1] |
| 1β-6-16 | 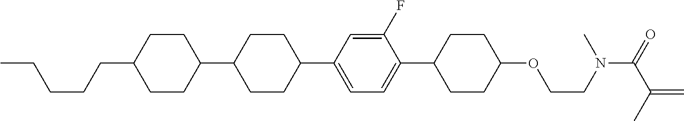 [SMILES: C=C(C)C(=O)N(C)CCOC1CCC(c2ccc(C3CCC(C4CCC(CCCCC)CC4)CC3)cc2F)CC1] |
| 1β-6-17 | 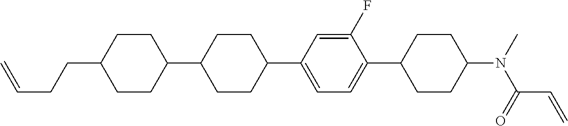 [SMILES: C=CCCC1CCC(C2CCC(c3ccc(C4CCC(N(C)C(=O)C=C)CC4)c(F)c3)CC2)CC1] |
| 1β-6-18 | 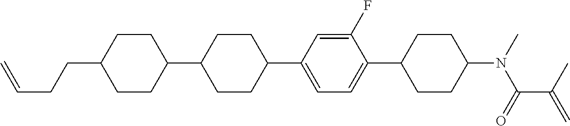 [SMILES: C=CCCC1CCC(C2CCC(c3ccc(C4CCC(N(C)C(=O)C(=C)C)CC4)c(F)c3)CC2)CC1] |
| 1β-6-19 | 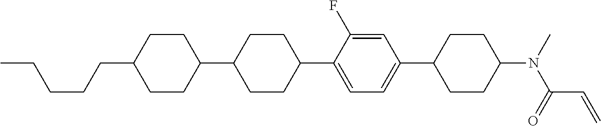 [SMILES: C=CC(=O)N(C)C1CCC(c2ccc(C3CCC(C4CCC(CCCCC)CC4)CC3)c(F)c2)CC1] |
| 1β-6-20 | 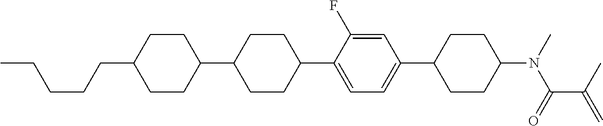 [SMILES: C=C(C)C(=O)N(C)C1CCC(c2ccc(C3CCC(C4CCC(CCCCC)CC4)CC3)c(F)c2)CC1] |
| 1β-6-21 | 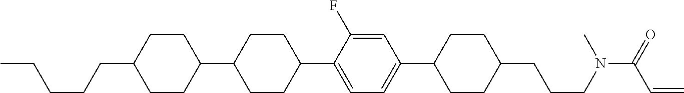 [SMILES: C=CC(=O)N(C)CCCC1CCC(c2ccc(C3CCC(C4CCC(CCCCC)CC4)CC3)c(F)c2)CC1] |
| 1β-6-22 | 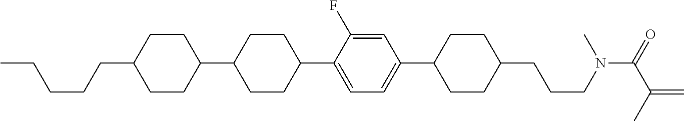 [SMILES: C=C(C)C(=O)N(C)CCCC1CCC(c2ccc(C3CCC(C4CCC(CCCCC)CC4)CC3)c(F)c2)CC1] |
| 1β-6-23 | 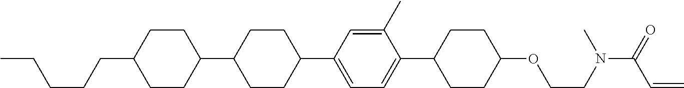 [SMILES: C=CC(=O)N(C)CCOC1CCC(c2ccc(C3CCC(C4CCC(CCCCC)CC4)CC3)cc2C)CC1] |
| 1β-6-24 | 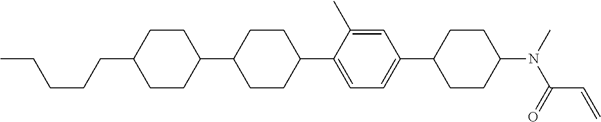 [SMILES: C=CC(=O)N(C)C1CCC(c2ccc(C3CCC(C4CCC(CCCCC)CC4)CC3)c(C)c2)CC1] |
| 1β-6-25 | 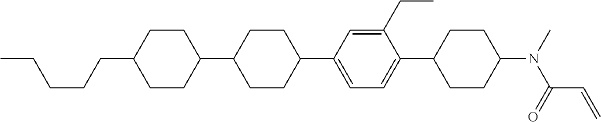 [SMILES: C=CC(=O)N(C)C1CCC(c2ccc(C3CCC(C4CCC(CCCCC)CC4)CC3)cc2CC)CC1] |
| 1β-6-26 | 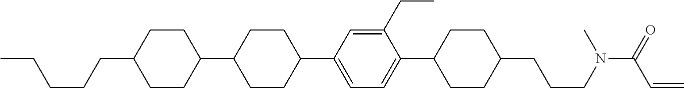 [SMILES: C=CC(=O)N(C)CCCC1CCC(c2ccc(C3CCC(C4CCC(CCCCC)CC4)CC3)cc2CC)CC1] |
| 1β-6-27 | 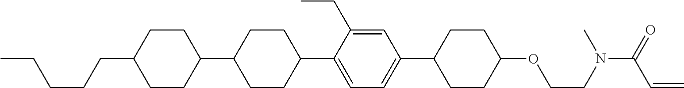 [SMILES: C=CC(=O)N(C)CCOC1CCC(c2ccc(C3CCC(C4CCC(CCCCC)CC4)CC3)c(CC)c2)CC1] |
| 1β-6-28 | 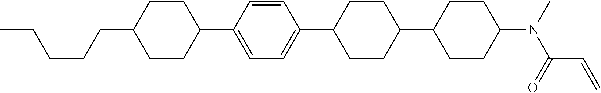 [SMILES: C=CC(=O)N(C)C1CCC(C2CCC(c3ccc(C4CCC(CCCCC)CC4)cc3)CC2)CC1] |
| 1β-6-29 | 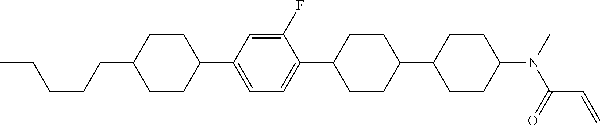 [SMILES: C=CC(=O)N(C)C1CCC(C2CCC(c3ccc(C4CCC(CCCCC)CC4)cc3F)CC2)CC1] |
| 1β-6-30 | 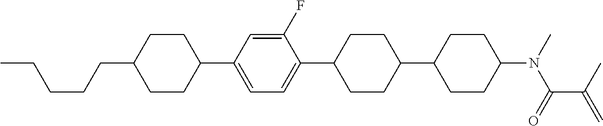 [SMILES: C=C(C)C(=O)N(C)C1CCC(C2CCC(c3ccc(C4CCC(CCCCC)CC4)cc3F)CC2)CC1] |
| 1β-6-31 | 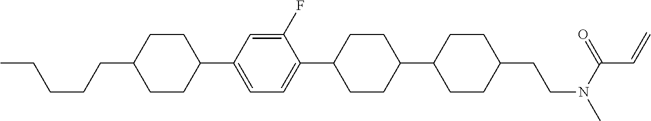 [SMILES: C=CC(=O)N(C)CCC1CCC(C2CCC(c3ccc(C4CCC(CCCCC)CC4)cc3F)CC2)CC1] |
| 1β-6-32 | 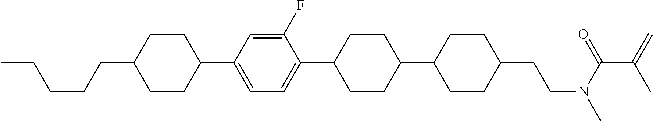 [SMILES: C=C(C)C(=O)N(C)CCC1CCC(C2CCC(c3ccc(C4CCC(CCCCC)CC4)cc3F)CC2)CC1] |
| 1β-6-33 | 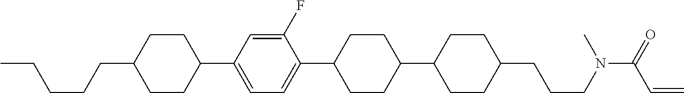 [SMILES: C=CC(=O)N(C)CCCC1CCC(C2CCC(c3ccc(C4CCC(CCCCC)CC4)cc3F)CC2)CC1] |
| 1β-6-34 | 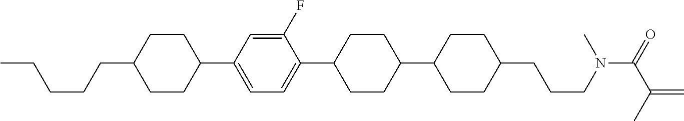 [SMILES: C=C(C)C(=O)N(C)CCCC1CCC(C2CCC(c3ccc(C4CCC(CCCCC)CC4)cc3F)CC2)CC1] |
| 1β-6-35 | 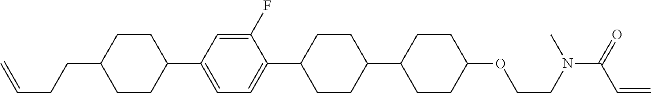 [SMILES: C=CCCC1CCC(c2ccc(C3CCC(C4CCC(OCCN(C)C(=O)C=C)CC4)CC3)c(F)c2)CC1] |
| 1β-6-36 | 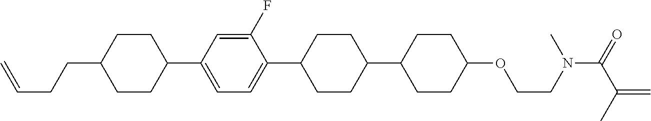 [SMILES: C=CCCC1CCC(c2ccc(C3CCC(C4CCC(OCCN(C)C(=O)C(=C)C)CC4)CC3)c(F)c2)CC1] |
| 1β-6-37 | 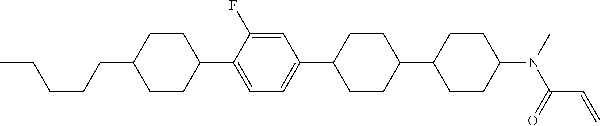 [SMILES: C=CC(=O)N(C)C1CCC(C2CCC(c3ccc(C4CCC(CCCCC)CC4)c(F)c3)CC2)CC1] |
| 1β-6-38 | 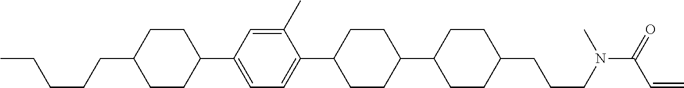 [SMILES: C=CC(=O)N(C)CCCC1CCC(C2CCC(c3ccc(C4CCC(CCCCC)CC4)cc3C)CC2)CC1] |
| 1β-6-39 | 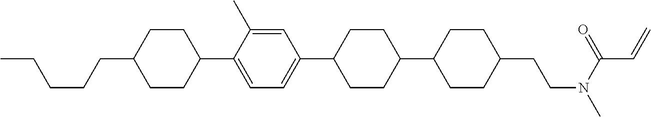 [SMILES: C=CC(=O)N(C)CCC1CCC(C2CCC(c3ccc(C4CCC(CCCCC)CC4)c(C)c3)CC2)CC1] |
| 1β-6-40 | 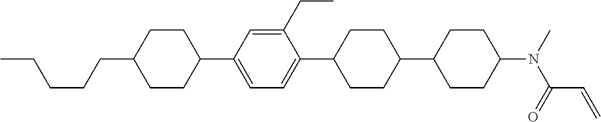 [SMILES: C=CC(=O)N(C)C1CCC(C2CCC(c3ccc(C4CCC(CCCCC)CC4)cc3CC)CC2)CC1] |
| 1β-6-41 | 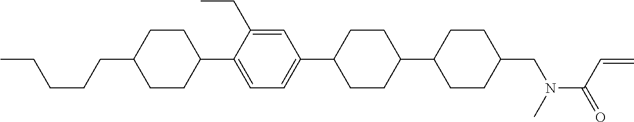 [SMILES: C=CC(=O)N(C)CC1CCC(C2CCC(c3ccc(C4CCC(CCCCC)CC4)c(CC)c3)CC2)CC1] |
| 1β-6-42 | 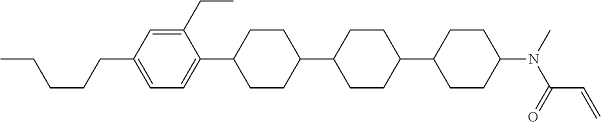 [SMILES: C=CC(=O)N(C)C1CCC(C2CCC(C3CCC(c4ccc(CCCCC)cc4CC)CC3)CC2)CC1] |
| 1β-6-43 | 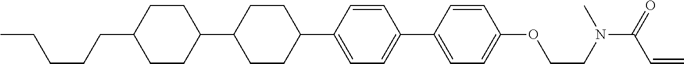 [SMILES: C=CC(=O)N(C)CCOc1ccc(-c2ccc(C3CCC(C4CCC(CCCCC)CC4)CC3)cc2)cc1] |
| 1β-6-44 | 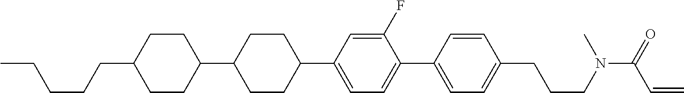 [SMILES: C=CC(=O)N(C)CCCc1ccc(-c2ccc(C3CCC(C4CCC(CCCCC)CC4)CC3)cc2F)cc1] |
| 1β-6-45 | 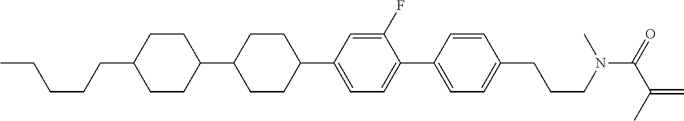 [SMILES: C=C(C)C(=O)N(C)CCCc1ccc(-c2ccc(C3CCC(C4CCC(CCCCC)CC4)CC3)cc2F)cc1] |
| 1β-6-46 | 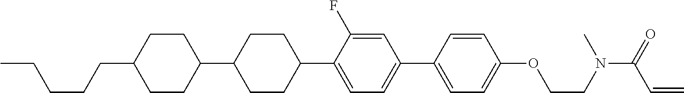 [SMILES: C=CC(=O)N(C)CCOc1ccc(-c2ccc(C3CCC(C4CCC(CCCCC)CC4)CC3)c(F)c2)cc1] |
| 1β-6-47 | 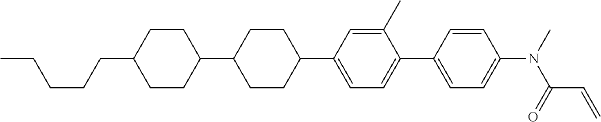 [SMILES: C=CC(=O)N(C)c1ccc(-c2ccc(C3CCC(C4CCC(CCCCC)CC4)CC3)cc2C)cc1] |
| 1β-6-48 | 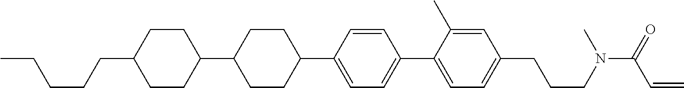 [SMILES: C=CC(=O)N(C)CCCc1ccc(-c2ccc(C3CCC(C4CCC(CCCCC)CC4)CC3)cc2)c(C)c1] |
| 1β-6-49 | 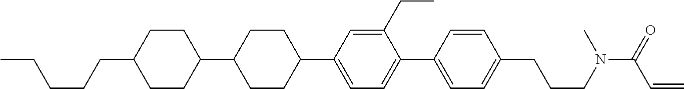 [SMILES: C=CC(=O)N(C)CCCc1ccc(-c2ccc(C3CCC(C4CCC(CCCCC)CC4)CC3)cc2CC)cc1] |
| 1β-6-50 | 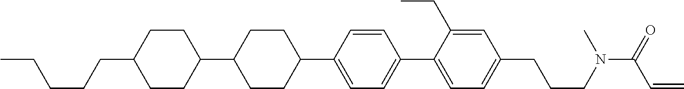 [SMILES: C=CC(=O)N(C)CCCc1ccc(-c2ccc(C3CCC(C4CCC(CCCCC)CC4)CC3)cc2)c(CC)c1] |
| 1β-6-51 | 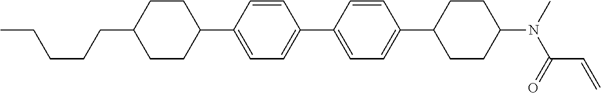 [SMILES: C=CC(=O)N(C)C1CCC(c2ccc(-c3ccc(C4CCC(CCCCC)CC4)cc3)cc2)CC1] |
| 1β-6-52 | 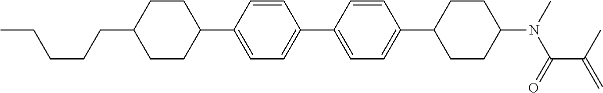 [SMILES: C=C(C)C(=O)N(C)C1CCC(c2ccc(-c3ccc(C4CCC(CCCCC)CC4)cc3)cc2)CC1] |
| 1β-6-53 | 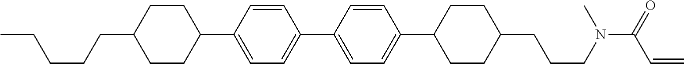 [SMILES: C=CC(=O)N(C)CCCC1CCC(c2ccc(-c3ccc(C4CCC(CCCCC)CC4)cc3)cc2)CC1] |
| 1β-6-54 | 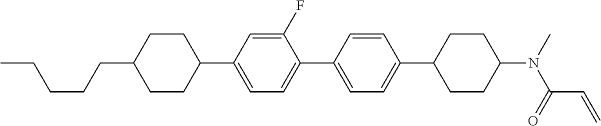 [SMILES: C=CC(=O)N(C)C1CCC(c2ccc(-c3ccc(C4CCC(CCCCC)CC4)cc3F)cc2)CC1] |
| 1β-6-55 | 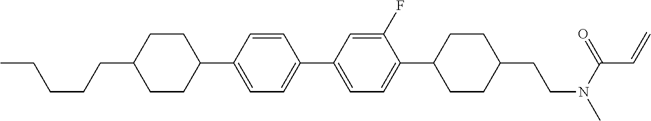 [SMILES: C=CC(=O)N(C)CCC1CCC(c2ccc(-c3ccc(C4CCC(CCCCC)CC4)cc3)cc2F)CC1] |
| 1β-6-56 | 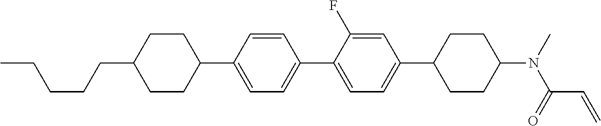 [SMILES: C=CC(=O)N(C)C1CCC(c2ccc(-c3ccc(C4CCC(CCCCC)CC4)cc3)c(F)c2)CC1] |
| 1β-6-57 | 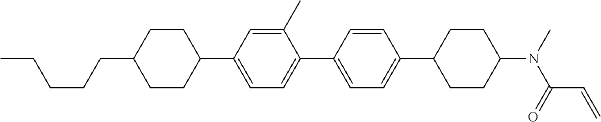 [SMILES: C=CC(=O)N(C)C1CCC(c2ccc(-c3ccc(C4CCC(CCCCC)CC4)cc3C)cc2)CC1] |
| 1β-6-58 | 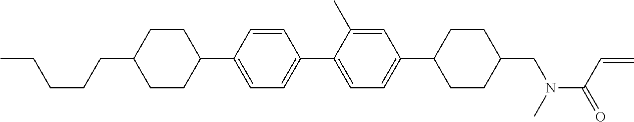 [SMILES: C=CC(=O)N(C)CC1CCC(c2ccc(-c3ccc(C4CCC(CCCCC)CC4)cc3)c(C)c2)CC1] |
| 1β-6-59 | 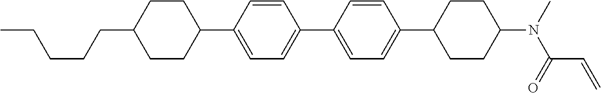 [SMILES: C=CC(=O)N(C)C1CCC(c2ccc(-c3ccc(C4CCC(CCCCC)CC4)cc3)cc2)CC1] |
| 1β-6-60 | 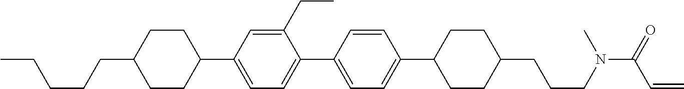 [SMILES: C=CC(=O)N(C)CCCC1CCC(c2ccc(-c3ccc(C4CCC(CCCCC)CC4)cc3CC)cc2)CC1] |
| 1β-6-61 | 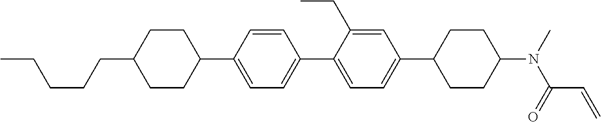 [SMILES: C=CC(=O)N(C)C1CCC(c2ccc(-c3ccc(C4CCC(CCCCC)CC4)cc3)c(CC)c2)CC1] |
| 1β-6-62 | 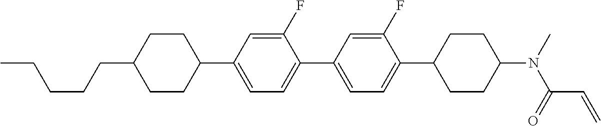 [SMILES: C=CC(=O)N(C)C1CCC(c2ccc(-c3ccc(C4CCC(CCCCC)CC4)cc3F)cc2F)CC1] |
| 1β-6-63 | 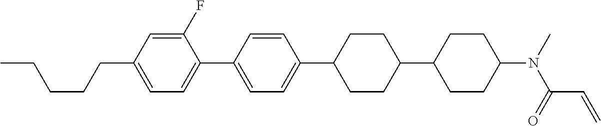 [SMILES: C=CC(=O)N(C)C1CCC(C2CCC(c3ccc(-c4ccc(CCCCC)cc4F)cc3)CC2)CC1] |
| 1β-6-64 | 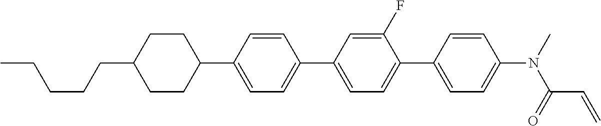 [SMILES: C=CC(=O)N(C)c1ccc(-c2ccc(-c3ccc(C4CCC(CCCCC)CC4)cc3)cc2F)cc1] |
| 1β-6-65 | 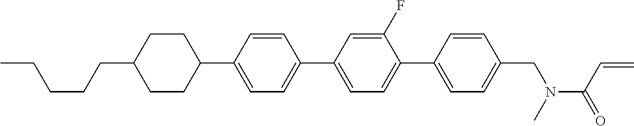 [SMILES: C=CC(=O)N(C)Cc1ccc(-c2ccc(-c3ccc(C4CCC(CCCCC)CC4)cc3)cc2F)cc1] |
| 1β-6-66 | 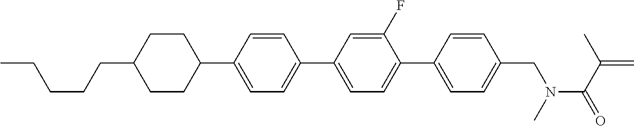 [SMILES: C=C(C)C(=O)N(C)Cc1ccc(-c2ccc(-c3ccc(C4CCC(CCCCC)CC4)cc3)cc2F)cc1] |
| 1β-6-67 | 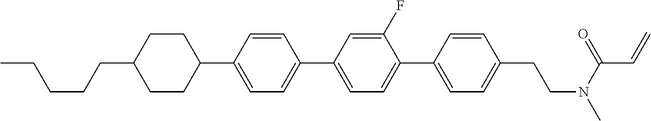 [SMILES: C=CC(=O)N(C)CCc1ccc(-c2ccc(-c3ccc(C4CCC(CCCCC)CC4)cc3)cc2F)cc1] |
| 1β-6-68 | 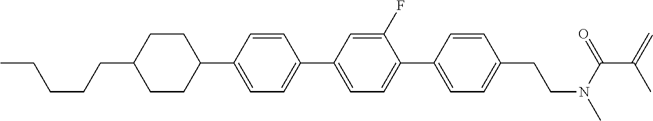 [SMILES: C=C(C)C(=O)N(C)CCc1ccc(-c2ccc(-c3ccc(C4CCC(CCCCC)CC4)cc3)cc2F)cc1] |
| 1β-6-69 | 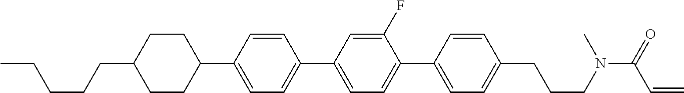 [SMILES: C=CC(=O)N(C)CCCc1ccc(-c2ccc(-c3ccc(C4CCC(CCCCC)CC4)cc3)cc2F)cc1] |
| 1β-6-70 | 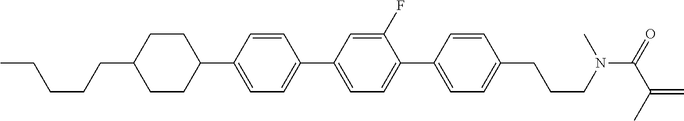 [SMILES: C=C(C)C(=O)N(C)CCCc1ccc(-c2ccc(-c3ccc(C4CCC(CCCCC)CC4)cc3)cc2F)cc1] |
| 1β-6-71 | 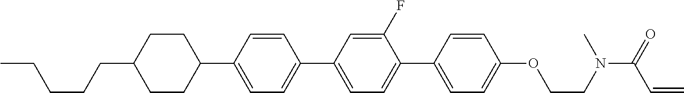 [SMILES: C=CC(=O)N(C)CCOc1ccc(-c2ccc(-c3ccc(C4CCC(CCCCC)CC4)cc3)cc2F)cc1] |
| 1β-6-72 | 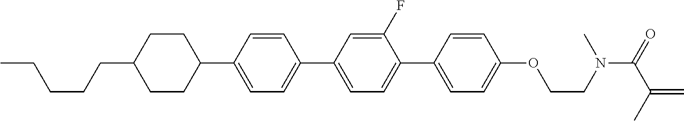 [SMILES: C=C(C)C(=O)N(C)CCOc1ccc(-c2ccc(-c3ccc(C4CCC(CCCCC)CC4)cc3)cc2F)cc1] |
| 1β-6-73 | 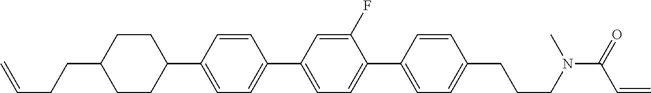 [SMILES: C=CCCC1CCC(c2ccc(-c3ccc(-c4ccc(CCCN(C)C(=O)C=C)cc4)c(F)c3)cc2)CC1] |
| 1β-6-74 | 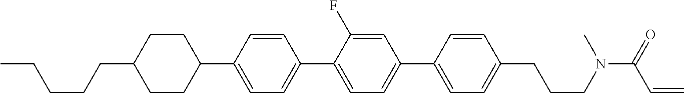 [SMILES: C=CC(=O)N(C)CCCc1ccc(-c2ccc(-c3ccc(C4CCC(CCCCC)CC4)cc3)c(F)c2)cc1] |
| 1β-6-75 | 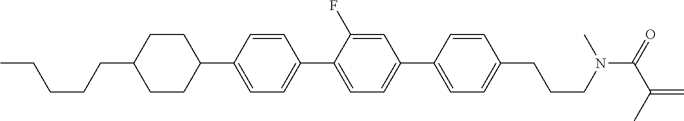 [SMILES: C=C(C)C(=O)N(C)CCCc1ccc(-c2ccc(-c3ccc(C4CCC(CCCCC)CC4)cc3)c(F)c2)cc1] |
| 1β-6-76 | 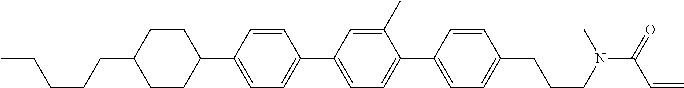 [SMILES: C=CC(=O)N(C)CCCc1ccc(-c2ccc(-c3ccc(C4CCC(CCCCC)CC4)cc3)cc2C)cc1] |
| 1β-6-77 | 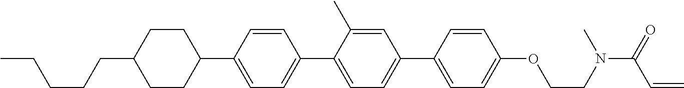 [SMILES: C=CC(=O)N(C)CCOc1ccc(-c2ccc(-c3ccc(C4CCC(CCCCC)CC4)cc3)c(C)c2)cc1] |
| 1β-6-78 | 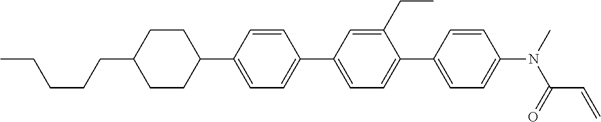 [SMILES: C=CC(=O)N(C)c1ccc(-c2ccc(-c3ccc(C4CCC(CCCCC)CC4)cc3)cc2CC)cc1] |
| 1β-6-79 | 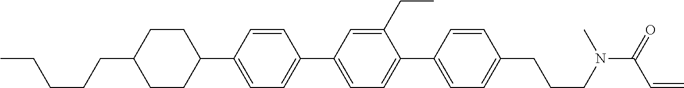 [SMILES: C=CC(=O)N(C)CCCc1ccc(-c2ccc(-c3ccc(C4CCC(CCCCC)CC4)cc3)cc2CC)cc1] |
| 1β-6-80 | 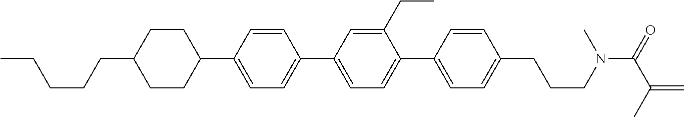 [SMILES: C=C(C)C(=O)N(C)CCCc1ccc(-c2ccc(-c3ccc(C4CCC(CCCCC)CC4)cc3)cc2CC)cc1] |
| 1β-6-81 | 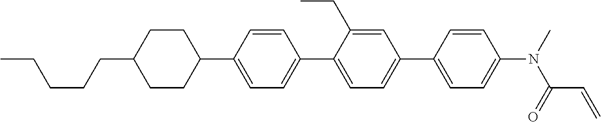 [SMILES: C=CC(=O)N(C)c1ccc(-c2ccc(-c3ccc(C4CCC(CCCCC)CC4)cc3)c(CC)c2)cc1] |
| 1β-6-82 | 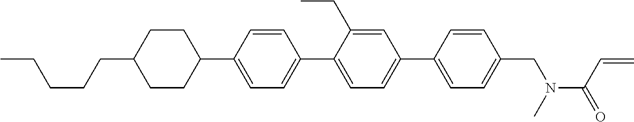 [SMILES: C=CC(=O)N(C)Cc1ccc(-c2ccc(-c3ccc(C4CCC(CCCCC)CC4)cc3)c(CC)c2)cc1] |
| 1β-6-83 | 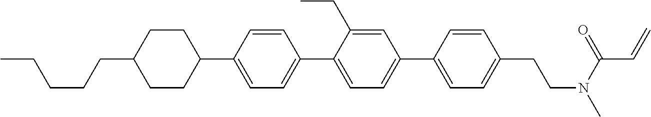 [SMILES: C=CC(=O)N(C)CCc1ccc(-c2ccc(-c3ccc(C4CCC(CCCCC)CC4)cc3)c(CC)c2)cc1] |
| 1β-6-84 | 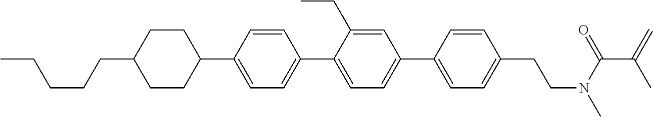 [SMILES: C=C(C)C(=O)N(C)CCc1ccc(-c2ccc(-c3ccc(C4CCC(CCCCC)CC4)cc3)c(CC)c2)cc1] |
| 1β-6-85 | 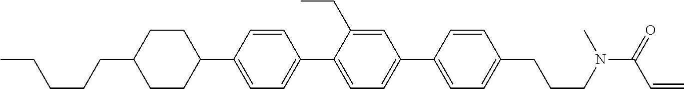 [SMILES: C=CC(=O)N(C)CCCc1ccc(-c2ccc(-c3ccc(C4CCC(CCCCC)CC4)cc3)c(CC)c2)cc1] |
| 1β-6-86 | 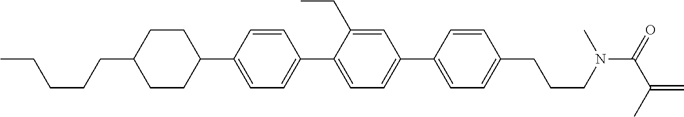 [SMILES: C=C(C)C(=O)N(C)CCCc1ccc(-c2ccc(-c3ccc(C4CCC(CCCCC)CC4)cc3)c(CC)c2)cc1] |
| 1β-6-87 | 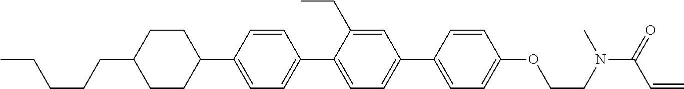 [SMILES: C=CC(=O)N(C)CCOc1ccc(-c2ccc(-c3ccc(C4CCC(CCCCC)CC4)cc3)c(CC)c2)cc1] |
| 1β-6-88 | 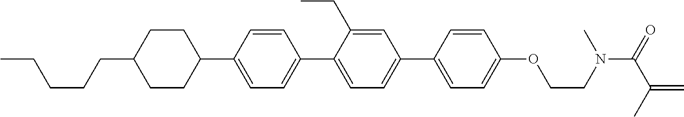 [SMILES: C=C(C)C(=O)N(C)CCOc1ccc(-c2ccc(-c3ccc(C4CCC(CCCCC)CC4)cc3)c(CC)c2)cc1] |
| 1β-6-89 | 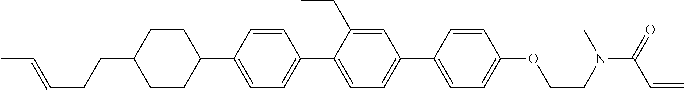 [SMILES: C=CC(=O)N(C)CCOc1ccc(-c2ccc(-c3ccc(C4CCC(CC/C=C/C)CC4)cc3)c(CC)c2)cc1] |
| 1β-6-90 | 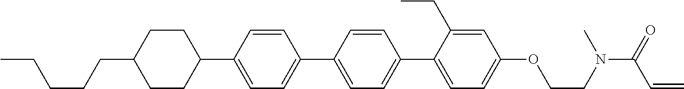 [SMILES: C=CC(=O)N(C)CCOc1ccc(-c2ccc(-c3ccc(C4CCC(CCCCC)CC4)cc3)cc2)c(CC)c1] |
| 1β-6-91 | 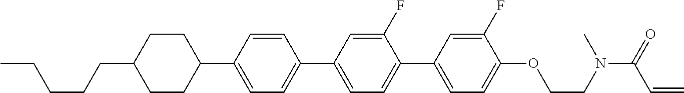 [SMILES: C=CC(=O)N(C)CCOc1ccc(-c2ccc(-c3ccc(C4CCC(CCCCC)CC4)cc3)cc2F)cc1F] |
| 1β-6-92 | 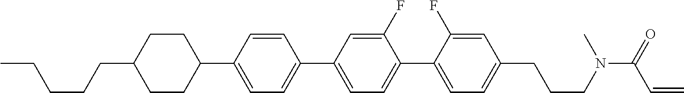 [SMILES: C=CC(=O)N(C)CCCc1ccc(-c2ccc(-c3ccc(C4CCC(CCCCC)CC4)cc3)cc2F)c(F)c1] |
| 1β-6-93 | 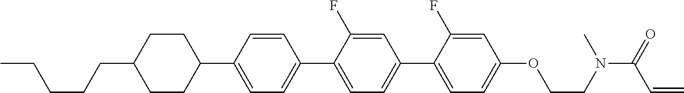 [SMILES: C=CC(=O)N(C)CCOc1ccc(-c2ccc(-c3ccc(C4CCC(CCCCC)CC4)cc3)c(F)c2)c(F)c1] |
| 1β-6-94 | 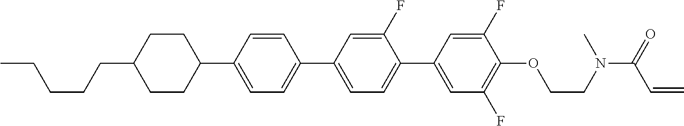 [SMILES: C=CC(=O)N(C)CCOc1c(F)cc(-c2ccc(-c3ccc(C4CCC(CCCCC)CC4)cc3)cc2F)cc1F] |
| 1β-6-95 | 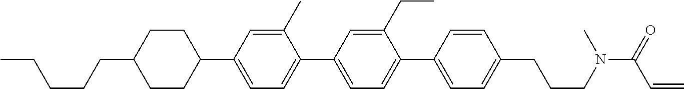 [SMILES: C=CC(=O)N(C)CCCc1ccc(-c2ccc(-c3ccc(C4CCC(CCCCC)CC4)cc3C)cc2CC)cc1] |
| 1β-6-96 | 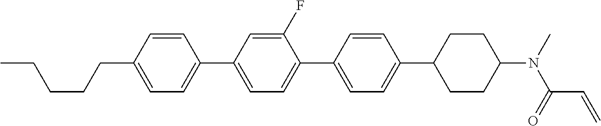 [SMILES: C=CC(=O)N(C)C1CCC(c2ccc(-c3ccc(-c4ccc(CCCCC)cc4)cc3F)cc2)CC1] |
| 1β-6-97 | 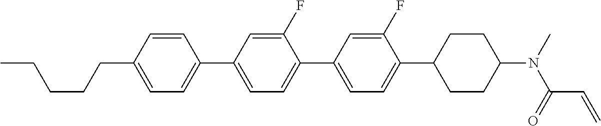 [SMILES: C=CC(=O)N(C)C1CCC(c2ccc(-c3ccc(-c4ccc(CCCCC)cc4)cc3F)cc2F)CC1] |
| 1β-6-98 | 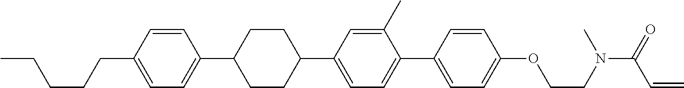 [SMILES: C=CC(=O)N(C)CCOc1ccc(-c2ccc(C3CCC(c4ccc(CCCCC)cc4)CC3)cc2C)cc1] |
| 1β-6-99 | 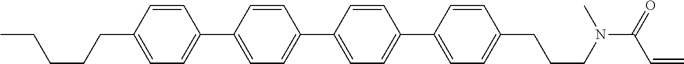 [SMILES: C=CC(=O)N(C)CCCc1ccc(-c2ccc(-c3ccc(-c4ccc(CCCCC)cc4)cc3)cc2)cc1] |
| 1β-6-100 | 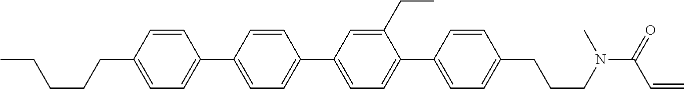 [SMILES: C=CC(=O)N(C)CCCc1ccc(-c2ccc(-c3ccc(-c4ccc(CCCCC)cc4)cc3)cc2CC)cc1] |
| 1β-6-101 | 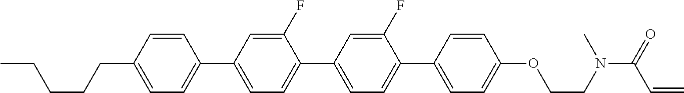 [SMILES: C=CC(=O)N(C)CCOc1ccc(-c2ccc(-c3ccc(-c4ccc(CCCCC)cc4)cc3F)cc2F)cc1] |
| 1β-6-102 | 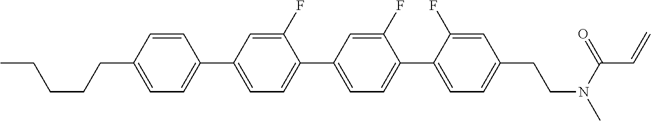 [SMILES: C=CC(=O)N(C)CCc1ccc(-c2ccc(-c3ccc(-c4ccc(CCCCC)cc4)cc3F)cc2F)c(F)c1] |
| 1β-6-103 | 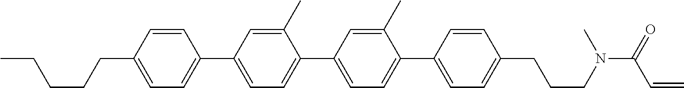 [SMILES: C=CC(=O)N(C)CCCc1ccc(-c2ccc(-c3ccc(-c4ccc(CCCCC)cc4)cc3C)cc2C)cc1] |
| 1β-6-104 | 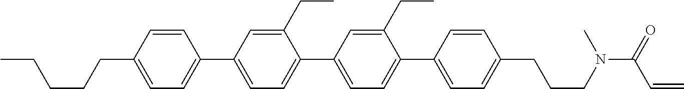 [SMILES: C=CC(=O)N(C)CCCc1ccc(-c2ccc(-c3ccc(-c4ccc(CCCCC)cc4)cc3CC)cc2CC)cc1] |
| 1β-6-105 | 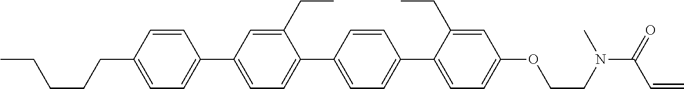 [SMILES: C=CC(=O)N(C)CCOc1ccc(-c2ccc(-c3ccc(-c4ccc(CCCCC)cc4)cc3CC)cc2)c(CC)c1] |
| 1β-6-106 | 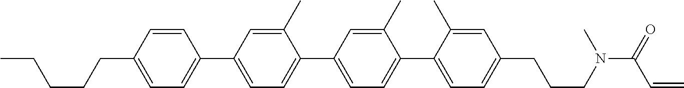 [SMILES: C=CC(=O)N(C)CCCc1ccc(-c2ccc(-c3ccc(-c4ccc(CCCCC)cc4)cc3C)cc2C)c(C)c1] |
| 1β-6-107 | 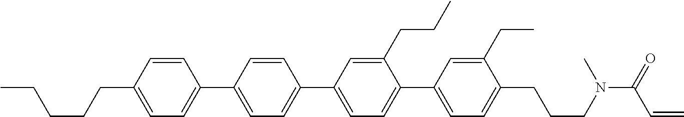 [SMILES: C=CC(=O)N(C)CCCc1ccc(-c2ccc(-c3ccc(-c4ccc(CCCCC)cc4)cc3)cc2CCC)cc1CC] |
| 1β-6-108 | 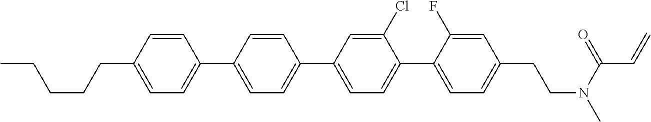 [SMILES: C=CC(=O)N(C)CCc1ccc(-c2ccc(-c3ccc(-c4ccc(CCCCC)cc4)cc3)cc2Cl)c(F)c1] |
| 1β-6-109 | 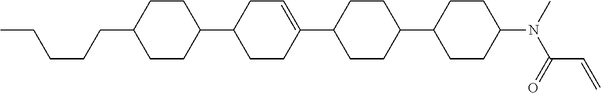 [SMILES: C=CC(=O)N(C)C1CCC(C2CCC(C3=CCC(C4CCC(CCCCC)CC4)CC3)CC2)CC1] |
| 1β-6-110 | 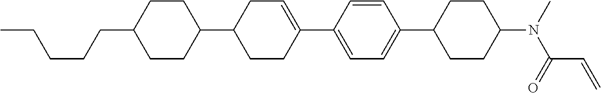 [SMILES: C=CC(=O)N(C)C1CCC(c2ccc(C3=CCC(C4CCC(CCCCC)CC4)CC3)cc2)CC1] |
| 1β-6-111 | 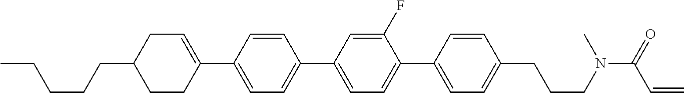 [SMILES: C=CC(=O)N(C)CCCc1ccc(-c2ccc(-c3ccc(C4=CCC(CCCCC)CC4)cc3)cc2F)cc1] |
| 1β-6-112 | 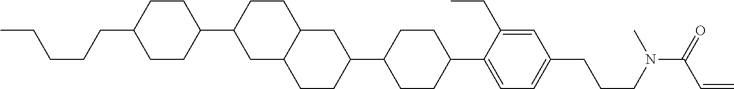 [SMILES: C=CC(=O)N(C)CCCc1ccc(C2CCC(C3CCC4CC(C5CCC(CCCCC)CC5)CCC4C3)CC2)c(CC)c1] |
| 1β-6-113 | 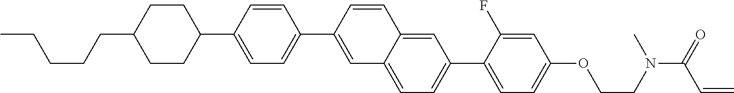 [SMILES: C=CC(=O)N(C)CCOc1ccc(-c2ccc3cc(-c4ccc(C5CCC(CCCCC)CC5)cc4)ccc3c2)c(F)c1] |
| 1β-6-114 | 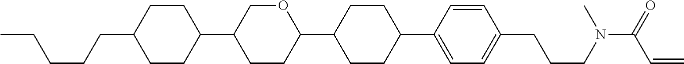 [SMILES: C=CC(=O)N(C)CCCc1ccc(C2CCC(C3CCC(C4CCC(CCCCC)CC4)CO3)CC2)cc1] |
| 1β-6-115 | 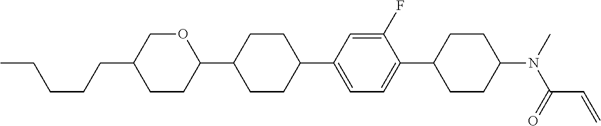 [SMILES: C=CC(=O)N(C)C1CCC(c2ccc(C3CCC(C4CCC(CCCCC)CO4)CC3)cc2F)CC1] |
| 1β-6-116 | 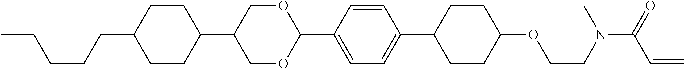 [SMILES: C=CC(=O)N(C)CCOC1CCC(c2ccc(C3OCC(C4CCC(CCCCC)CC4)CO3)cc2)CC1] |
| 1β-6-117 | 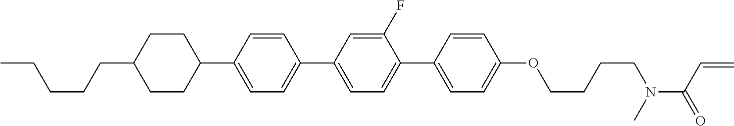 [SMILES: C=CC(=O)N(C)CCCCOc1ccc(-c2ccc(-c3ccc(C4CCC(CCCCC)CC4)cc3)cc2F)cc1] |
| 1β-6-118 | 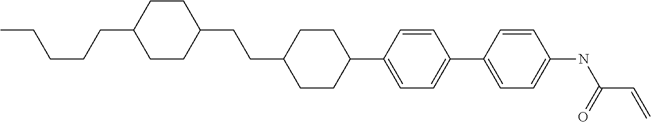 [SMILES: C=CC(=O)Nc1ccc(-c2ccc(C3CCC(CCC4CCC(CCCCC)CC4)CC3)cc2)cc1] |
| 1β-6-119 | 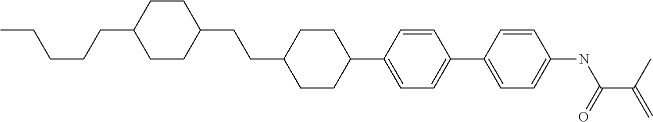 [SMILES: C=C(C)C(=O)Nc1ccc(-c2ccc(C3CCC(CCC4CCC(CCCCC)CC4)CC3)cc2)cc1] |
| 1β-6-120 | 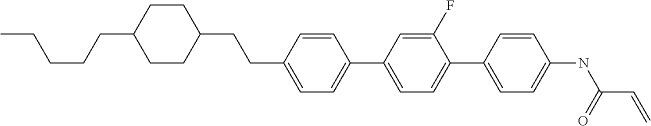 [SMILES: C=CC(=O)Nc1ccc(-c2ccc(-c3ccc(CCC4CCC(CCCCC)CC4)cc3)cc2F)cc1] |
| 1β-6-121 | 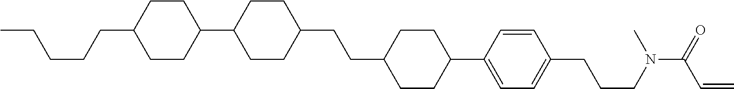 [SMILES: C=CC(=O)N(C)CCCc1ccc(C2CCC(CCC3CCC(C4CCC(CCCCC)CC4)CC3)CC2)cc1] |
| 1β-6-122 | 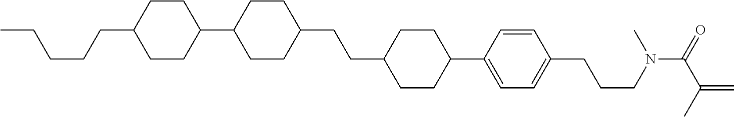 [SMILES: C=C(C)C(=O)N(C)CCCc1ccc(C2CCC(CCC3CCC(C4CCC(CCCCC)CC4)CC3)CC2)cc1] |
| 1β-6-123 | 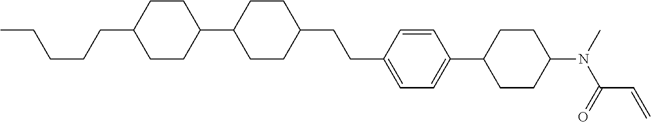 [SMILES: C=CC(=O)N(C)C1CCC(c2ccc(CCC3CCC(C4CCC(CCCCC)CC4)CC3)cc2)CC1] |
| 1β-6-124 | 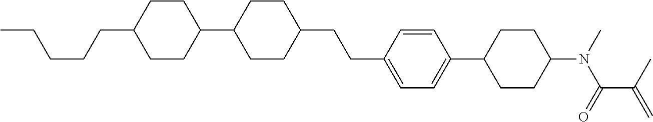 [SMILES: C=C(C)C(=O)N(C)C1CCC(c2ccc(CCC3CCC(C4CCC(CCCCC)CC4)CC3)cc2)CC1] |
| 1β-6-125 | 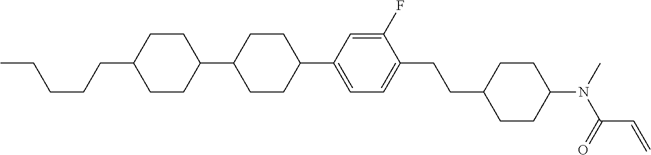 [SMILES: C=CC(=O)N(C)C1CCC(CCc2ccc(C3CCC(C4CCC(CCCCC)CC4)CC3)cc2F)CC1] |
| 1β-6-126 | 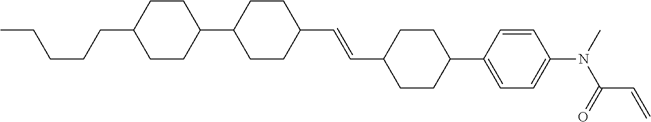 [SMILES: C=CC(=O)N(C)c1ccc(C2CCC(/C=C/C3CCC(C4CCC(CCCCC)CC4)CC3)CC2)cc1] |
| 1β-6-127 | 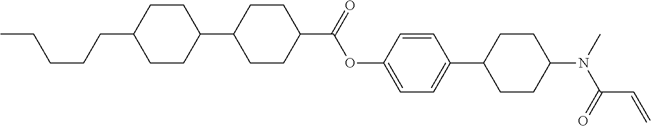 [SMILES: C=CC(=O)N(C)C1CCC(c2ccc(OC(=O)C3CCC(C4CCC(CCCCC)CC4)CC3)cc2)CC1] |
| 1β-6-128 | 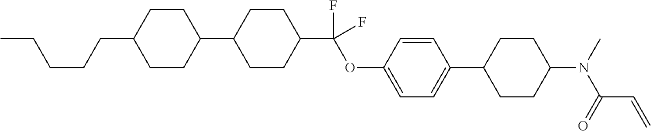 [SMILES: C=CC(=O)N(C)C1CCC(c2ccc(OC(F)(F)C3CCC(C4CCC(CCCCC)CC4)CC3)cc2)CC1] |
| 1β-6-129 | 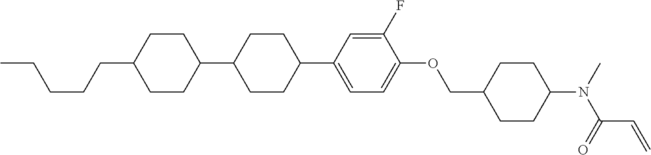 [SMILES: C=CC(=O)N(C)C1CCC(COc2ccc(C3CCC(C4CCC(CCCCC)CC4)CC3)cc2F)CC1] |
| 1β-6-130 | 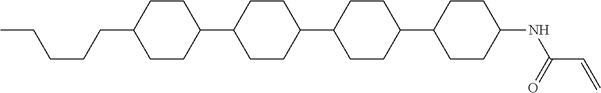 [SMILES: C=CC(=O)NC1CCC(C2CCC(C3CCC(C4CCC(CCCCC)CC4)CC3)CC2)CC1] |
| 1β-6-131 | 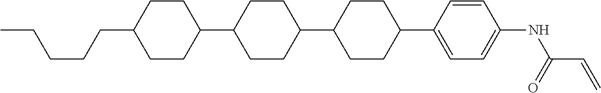 [SMILES: C=CC(=O)Nc1ccc(C2CCC(C3CCC(C4CCC(CCCCC)CC4)CC3)CC2)cc1] |
| 1β-6-132 | 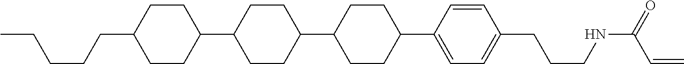 [SMILES: C=CC(=O)NCCCc1ccc(C2CCC(C3CCC(C4CCC(CCCCC)CC4)CC3)CC2)cc1] |
| 1β-6-133 | 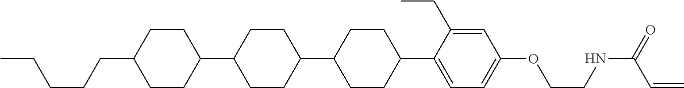 [SMILES: C=CC(=O)NCCOc1ccc(C2CCC(C3CCC(C4CCC(CCCCC)CC4)CC3)CC2)c(CC)c1] |
| 1β-6-134 | 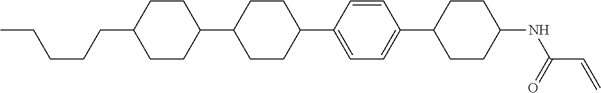 [SMILES: C=CC(=O)NC1CCC(c2ccc(C3CCC(C4CCC(CCCCC)CC4)CC3)cc2)CC1] |
| 1β-6-135 | 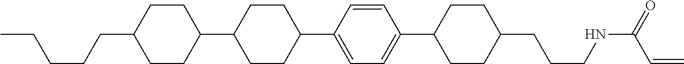 [SMILES: C=CC(=O)NCCCC1CCC(c2ccc(C3CCC(C4CCC(CCCCC)CC4)CC3)cc2)CC1] |
| 1β-6-136 | 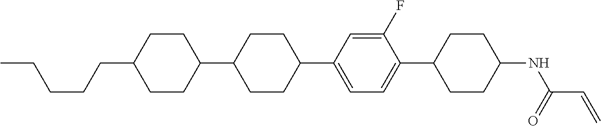 [SMILES: C=CC(=O)NC1CCC(c2ccc(C3CCC(C4CCC(CCCCC)CC4)CC3)cc2F)CC1] |
| 1β-6-137 | 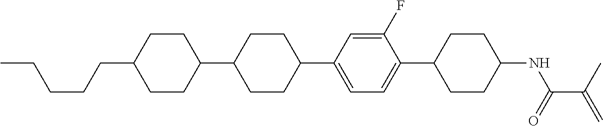 [SMILES: C=C(C)C(=O)NC1CCC(c2ccc(C3CCC(C4CCC(CCCCC)CC4)CC3)cc2F)CC1] |
| 1β-6-138 | 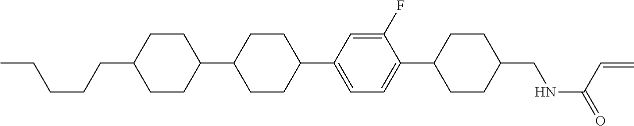 [SMILES: C=CC(=O)NCC1CCC(c2ccc(C3CCC(C4CCC(CCCCC)CC4)CC3)cc2F)CC1] |
| 1β-6-139 | 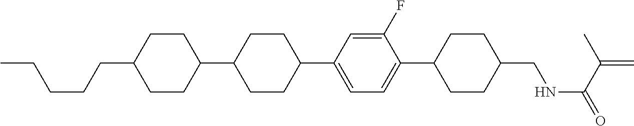 [SMILES: C=C(C)C(=O)NCC1CCC(c2ccc(C3CCC(C4CCC(CCCCC)CC4)CC3)cc2F)CC1] |
| 1β-6-140 | 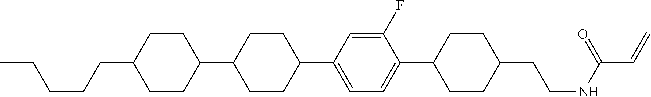 [SMILES: C=CC(=O)NCCC1CCC(c2ccc(C3CCC(C4CCC(CCCCC)CC4)CC3)cc2F)CC1] |
| 1β-6-141 | 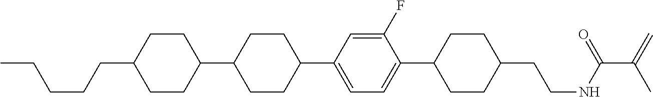 [SMILES: C=C(C)C(=O)NCCC1CCC(c2ccc(C3CCC(C4CCC(CCCCC)CC4)CC3)cc2F)CC1] |
| 1β-6-142 | 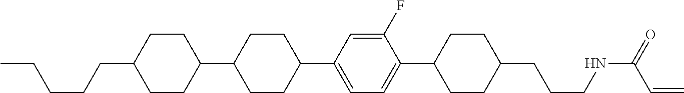 [SMILES: C=CC(=O)NCCCC1CCC(c2ccc(C3CCC(C4CCC(CCCCC)CC4)CC3)cc2F)CC1] |
| 1β-6-143 | 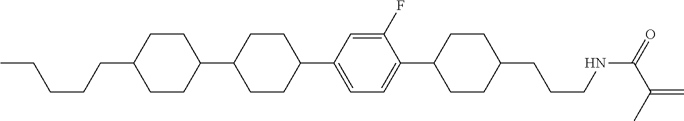 [SMILES: C=C(C)C(=O)NCCCC1CCC(c2ccc(C3CCC(C4CCC(CCCCC)CC4)CC3)cc2F)CC1] |
| 1β-6-144 | 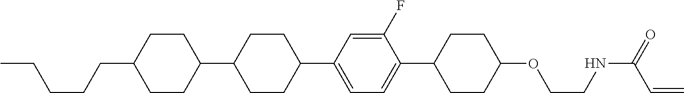 [SMILES: C=CC(=O)NCCOC1CCC(c2ccc(C3CCC(C4CCC(CCCCC)CC4)CC3)cc2F)CC1] |
| 1β-6-145 | 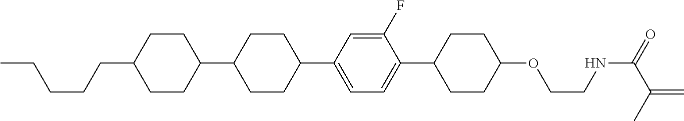 [SMILES: C=C(C)C(=O)NCCOC1CCC(c2ccc(C3CCC(C4CCC(CCCCC)CC4)CC3)cc2F)CC1] |
| 1β-6-146 | 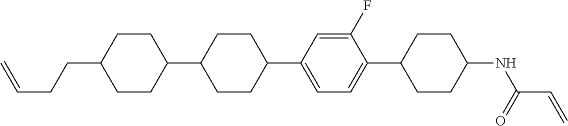 [SMILES: C=CCCC1CCC(C2CCC(c3ccc(C4CCC(NC(=O)C=C)CC4)c(F)c3)CC2)CC1] |
| 1β-6-147 | 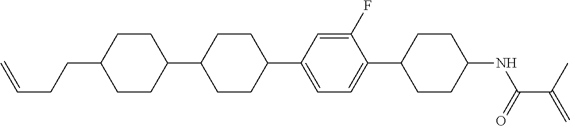 [SMILES: C=CCCC1CCC(C2CCC(c3ccc(C4CCC(NC(=O)C(=C)C)CC4)c(F)c3)CC2)CC1] |
| 1β-6-148 | 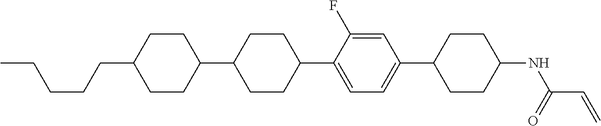 [SMILES: C=CC(=O)NC1CCC(c2ccc(C3CCC(C4CCC(CCCCC)CC4)CC3)c(F)c2)CC1] |
| 1β-6-149 | 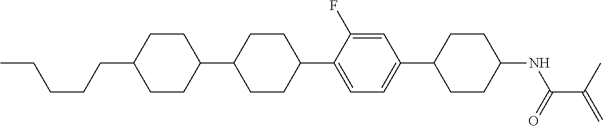 [SMILES: C=C(C)C(=O)NC1CCC(c2ccc(C3CCC(C4CCC(CCCCC)CC4)CC3)c(F)c2)CC1] |
| 1β-6-150 | 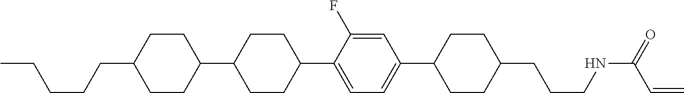 [SMILES: C=CC(=O)NCCCC1CCC(c2ccc(C3CCC(C4CCC(CCCCC)CC4)CC3)c(F)c2)CC1] |
| 1β-6-151 | 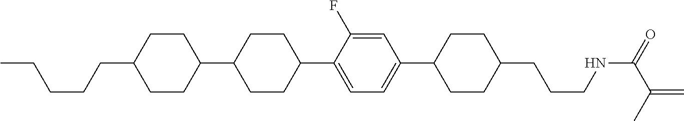 [SMILES: C=C(C)C(=O)NCCCC1CCC(c2ccc(C3CCC(C4CCC(CCCCC)CC4)CC3)c(F)c2)CC1] |
| 1β-6-152 | 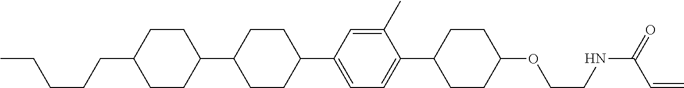 [SMILES: C=CC(=O)NCCOC1CCC(c2ccc(C3CCC(C4CCC(CCCCC)CC4)CC3)cc2C)CC1] |
| 1β-6-153 | 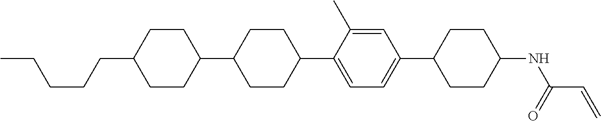 [SMILES: C=CC(=O)NC1CCC(c2ccc(C3CCC(C4CCC(CCCCC)CC4)CC3)c(C)c2)CC1] |
| 1β-6-154 | 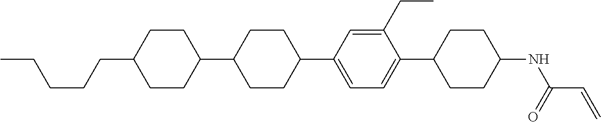 [SMILES: C=CC(=O)NC1CCC(c2ccc(C3CCC(C4CCC(CCCCC)CC4)CC3)cc2CC)CC1] |
| 1β-6-155 | 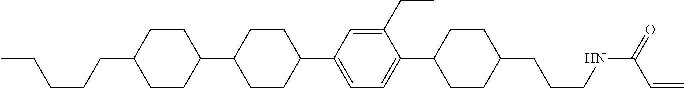 [SMILES: C=CC(=O)NCCCC1CCC(c2ccc(C3CCC(C4CCC(CCCCC)CC4)CC3)cc2CC)CC1] |
| 1β-6-156 | 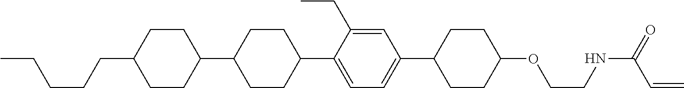 [SMILES: C=CC(=O)NCCOC1CCC(c2ccc(C3CCC(C4CCC(CCCCC)CC4)CC3)c(CC)c2)CC1] |
| 1β-6-157 | 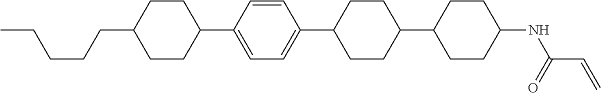 [SMILES: C=CC(=O)NC1CCC(C2CCC(c3ccc(C4CCC(CCCCC)CC4)cc3)CC2)CC1] |
| 1β-6-158 | 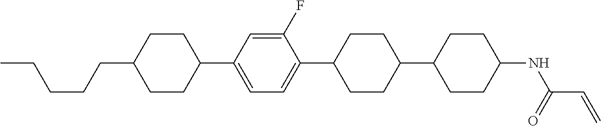 [SMILES: C=CC(=O)NC1CCC(C2CCC(c3ccc(C4CCC(CCCCC)CC4)cc3F)CC2)CC1] |
| 1β-6-159 | 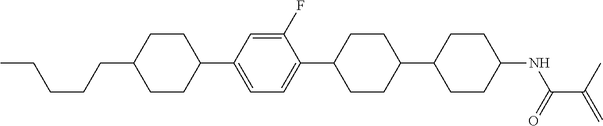 [SMILES: C=C(C)C(=O)NC1CCC(C2CCC(c3ccc(C4CCC(CCCCC)CC4)cc3F)CC2)CC1] |
| 1β-6-160 | 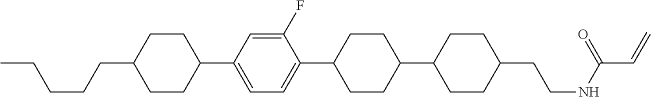 [SMILES: C=CC(=O)NCCC1CCC(C2CCC(c3ccc(C4CCC(CCCCC)CC4)cc3F)CC2)CC1] |
| 1β-6-161 | 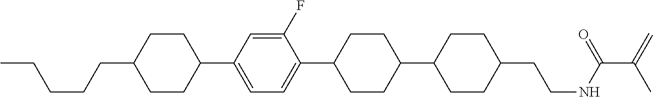 [SMILES: C=C(C)C(=O)NCCC1CCC(C2CCC(c3ccc(C4CCC(CCCCC)CC4)cc3F)CC2)CC1] |
| 1β-6-162 | 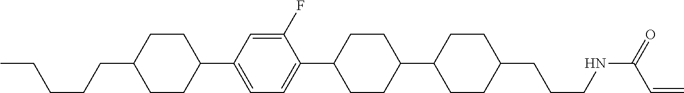 [SMILES: C=CC(=O)NCCCC1CCC(C2CCC(c3ccc(C4CCC(CCCCC)CC4)cc3F)CC2)CC1] |
| 1β-6-163 | 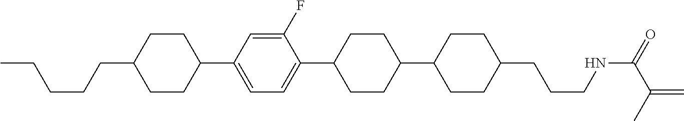 [SMILES: C=C(C)C(=O)NCCCC1CCC(C2CCC(c3ccc(C4CCC(CCCCC)CC4)cc3F)CC2)CC1] |
| 1β-6-164 | 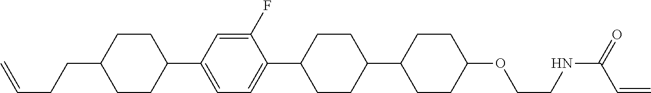 [SMILES: C=CCCC1CCC(c2ccc(C3CCC(C4CCC(OCCNC(=O)C=C)CC4)CC3)c(F)c2)CC1] |
| 1β-6-165 | 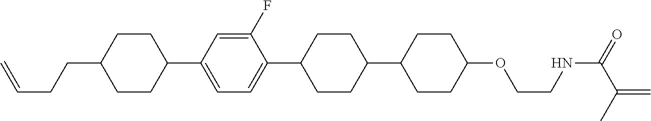 [SMILES: C=CCCC1CCC(c2ccc(C3CCC(C4CCC(OCCNC(=O)C(=C)C)CC4)CC3)c(F)c2)CC1] |
| 1β-6-166 | 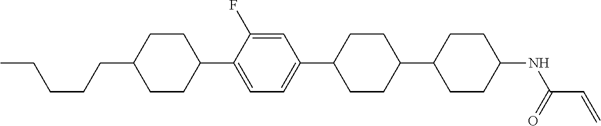 [SMILES: C=CC(=O)NC1CCC(C2CCC(c3ccc(C4CCC(CCCCC)CC4)c(F)c3)CC2)CC1] |
| 1β-6-167 | 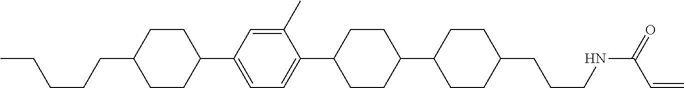 [SMILES: C=CC(=O)NCCCC1CCC(C2CCC(c3ccc(C4CCC(CCCCC)CC4)cc3C)CC2)CC1] |
| 1β-6-168 | 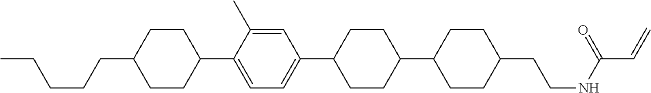 [SMILES: C=CC(=O)NCCC1CCC(C2CCC(c3ccc(C4CCC(CCCCC)CC4)c(C)c3)CC2)CC1] |
| 1β-6-169 | 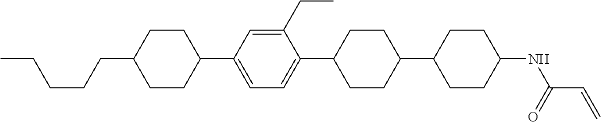 [SMILES: C=CC(=O)NC1CCC(C2CCC(c3ccc(C4CCC(CCCCC)CC4)cc3CC)CC2)CC1] |
| 1β-6-170 | 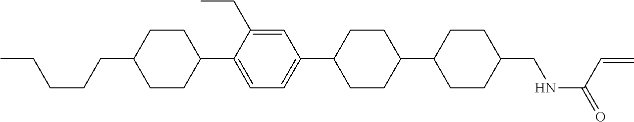 [SMILES: C=CC(=O)NCC1CCC(C2CCC(c3ccc(C4CCC(CCCCC)CC4)c(CC)c3)CC2)CC1] |
| 1β-6-171 | 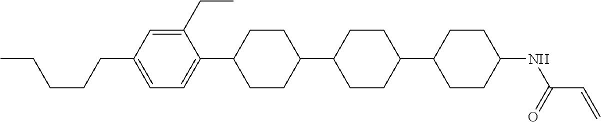 [SMILES: C=CC(=O)NC1CCC(C2CCC(C3CCC(c4ccc(CCCCC)cc4CC)CC3)CC2)CC1] |
| 1β-6-172 | 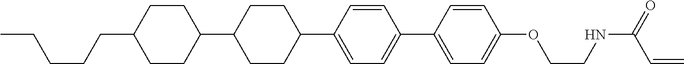 [SMILES: C=CC(=O)NCCOc1ccc(-c2ccc(C3CCC(C4CCC(CCCCC)CC4)CC3)cc2)cc1] |
| 1β-6-173 | 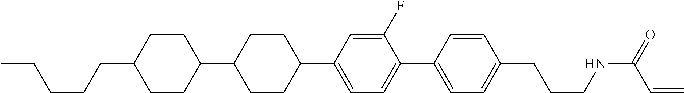 [SMILES: C=CC(=O)NCCCc1ccc(-c2ccc(C3CCC(C4CCC(CCCCC)CC4)CC3)cc2F)cc1] |
| 1β-6-174 | 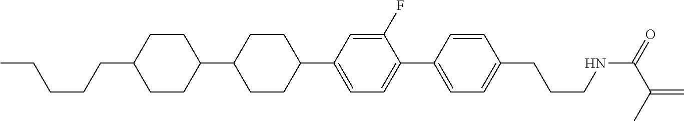 [SMILES: C=C(C)C(=O)NCCCc1ccc(-c2ccc(C3CCC(C4CCC(CCCCC)CC4)CC3)cc2F)cc1] |
| 1β-6-175 | 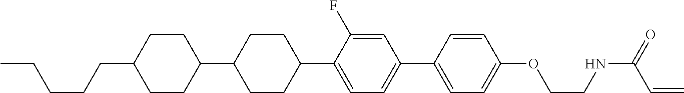 [SMILES: C=CC(=O)NCCOc1ccc(-c2ccc(C3CCC(C4CCC(CCCCC)CC4)CC3)c(F)c2)cc1] |
| 1β-6-176 | 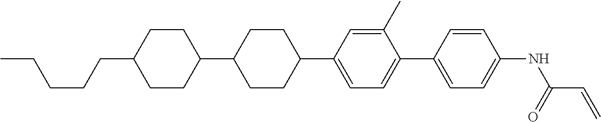 [SMILES: C=CC(=O)Nc1ccc(-c2ccc(C3CCC(C4CCC(CCCCC)CC4)CC3)cc2C)cc1] |
| 1β-6-177 | 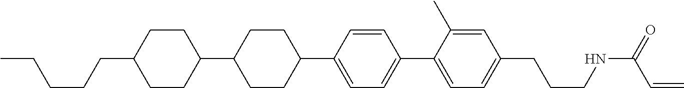 [SMILES: C=CC(=O)NCCCc1ccc(-c2ccc(C3CCC(C4CCC(CCCCC)CC4)CC3)cc2)c(C)c1] |
| 1β-6-178 | 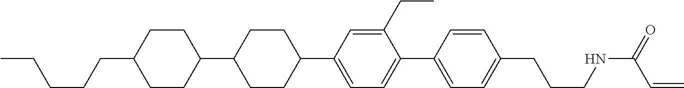 [SMILES: C=CC(=O)NCCCc1ccc(-c2ccc(C3CCC(C4CCC(CCCCC)CC4)CC3)cc2CC)cc1] |
| 1β-6-179 | 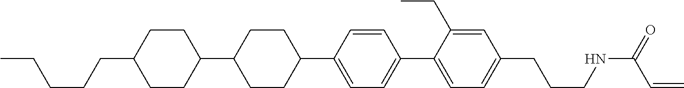 [SMILES: C=CC(=O)NCCCc1ccc(-c2ccc(C3CCC(C4CCC(CCCCC)CC4)CC3)cc2)c(CC)c1] |
| 1β-6-180 | 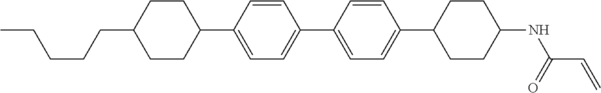 [SMILES: C=CC(=O)NC1CCC(c2ccc(-c3ccc(C4CCC(CCCCC)CC4)cc3)cc2)CC1] |
| 1β-6-181 | 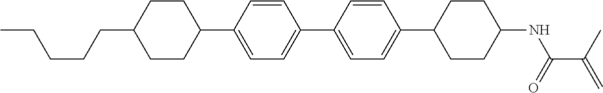 [SMILES: C=C(C)C(=O)NC1CCC(c2ccc(-c3ccc(C4CCC(CCCCC)CC4)cc3)cc2)CC1] |
| 1β-6-182 | 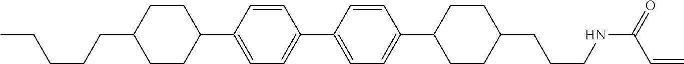 [SMILES: C=CC(=O)NCCCC1CCC(c2ccc(-c3ccc(C4CCC(CCCCC)CC4)cc3)cc2)CC1] |
| 1β-6-183 | 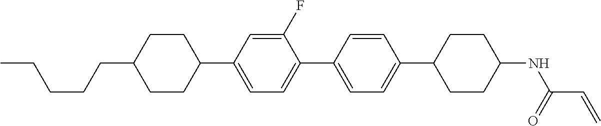 [SMILES: C=CC(=O)NC1CCC(c2ccc(-c3ccc(C4CCC(CCCCC)CC4)cc3F)cc2)CC1] |
| 1β-6-184 | 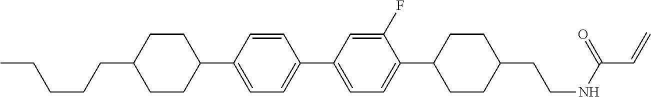 [SMILES: C=CC(=O)NCCC1CCC(c2ccc(-c3ccc(C4CCC(CCCCC)CC4)cc3)cc2F)CC1] |
| 1β-6-185 | 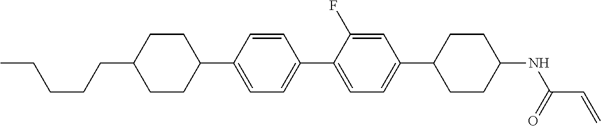 [SMILES: C=CC(=O)NC1CCC(c2ccc(-c3ccc(C4CCC(CCCCC)CC4)cc3)c(F)c2)CC1] |
| 1β-6-186 | 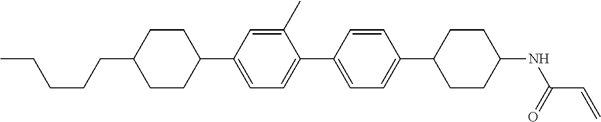 [SMILES: C=CC(=O)NC1CCC(c2ccc(-c3ccc(C4CCC(CCCCC)CC4)cc3C)cc2)CC1] |
| 1β-6-187 | 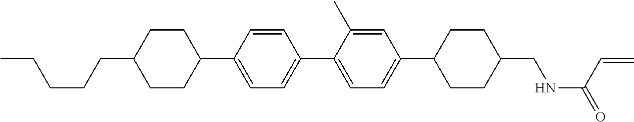 [SMILES: C=CC(=O)NCC1CCC(c2ccc(-c3ccc(C4CCC(CCCCC)CC4)cc3)c(C)c2)CC1] |
| 1β-6-188 | 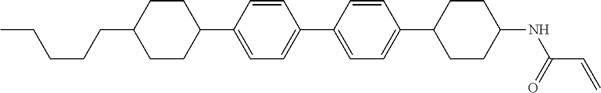 [SMILES: C=CC(=O)NC1CCC(c2ccc(-c3ccc(C4CCC(CCCCC)CC4)cc3)cc2)CC1] |
| 1β-6-189 | 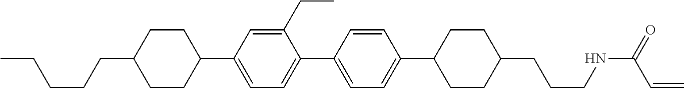 [SMILES: C=CC(=O)NCCCC1CCC(c2ccc(-c3ccc(C4CCC(CCCCC)CC4)cc3CC)cc2)CC1] |
| 1β-6-190 | 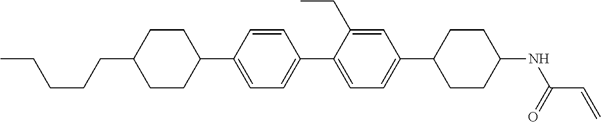 [SMILES: C=CC(=O)NC1CCC(c2ccc(-c3ccc(C4CCC(CCCCC)CC4)cc3)c(CC)c2)CC1] |
| 1β-6-191 | 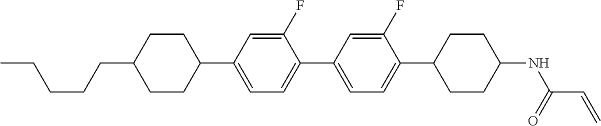 [SMILES: C=CC(=O)NC1CCC(c2ccc(-c3ccc(C4CCC(CCCCC)CC4)cc3F)cc2F)CC1] |
| 1β-6-192 | 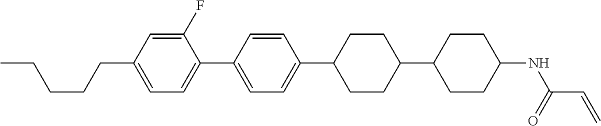 [SMILES: C=CC(=O)NC1CCC(C2CCC(c3ccc(-c4ccc(CCCCC)cc4F)cc3)CC2)CC1] |
| 1β-6-193 | 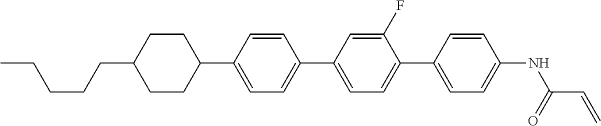 [SMILES: C=CC(=O)Nc1ccc(-c2ccc(-c3ccc(C4CCC(CCCCC)CC4)cc3)cc2F)cc1] |
| 1β-6-194 | 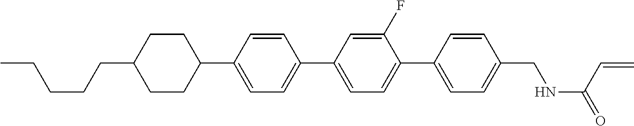 [SMILES: C=CC(=O)NCc1ccc(-c2ccc(-c3ccc(C4CCC(CCCCC)CC4)cc3)cc2F)cc1] |
| 1β-6-195 | 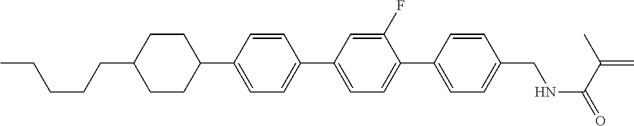 [SMILES: C=C(C)C(=O)NCc1ccc(-c2ccc(-c3ccc(C4CCC(CCCCC)CC4)cc3)cc2F)cc1] |
| 1β-6-196 | 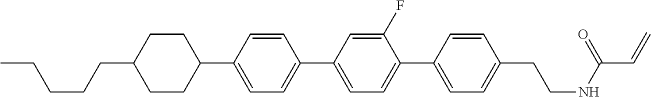 [SMILES: C=CC(=O)NCCc1ccc(-c2ccc(-c3ccc(C4CCC(CCCCC)CC4)cc3)cc2F)cc1] |
| 1β-6-197 | 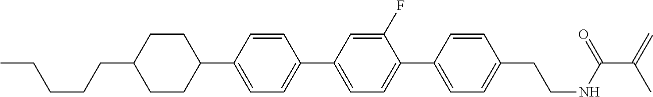 [SMILES: C=C(C)C(=O)NCCc1ccc(-c2ccc(-c3ccc(C4CCC(CCCCC)CC4)cc3)cc2F)cc1] |
| 1β-6-198 | 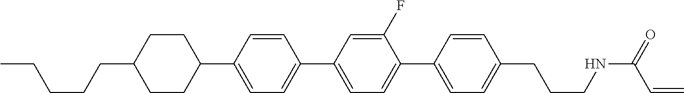 [SMILES: C=CC(=O)NCCCc1ccc(-c2ccc(-c3ccc(C4CCC(CCCCC)CC4)cc3)cc2F)cc1] |
| 1β-6-199 | 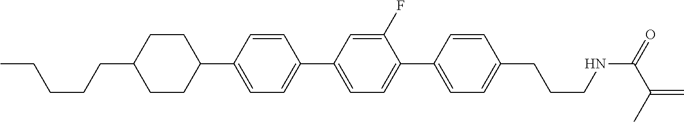 [SMILES: C=C(C)C(=O)NCCCc1ccc(-c2ccc(-c3ccc(C4CCC(CCCCC)CC4)cc3)cc2F)cc1] |
| 1β-6-200 | 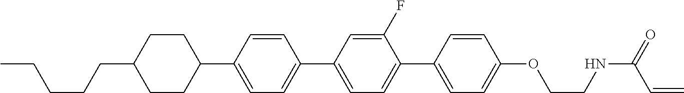 [SMILES: C=CC(=O)NCCOc1ccc(-c2ccc(-c3ccc(C4CCC(CCCCC)CC4)cc3)cc2F)cc1] |
| 1β-6-201 | 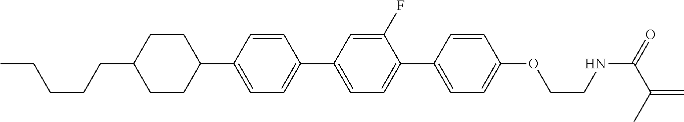 [SMILES: C=C(C)C(=O)NCCOc1ccc(-c2ccc(-c3ccc(C4CCC(CCCCC)CC4)cc3)cc2F)cc1] |
| 1β-6-202 | 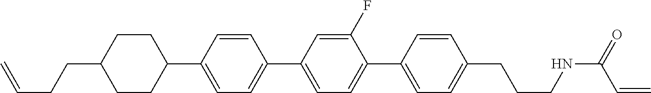 [SMILES: C=CCCC1CCC(c2ccc(-c3ccc(-c4ccc(CCCNC(=O)C=C)cc4)c(F)c3)cc2)CC1] |
| 1β-6-203 | 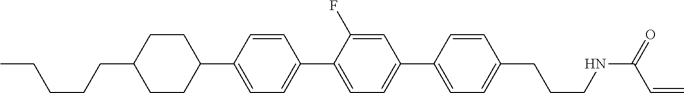 [SMILES: C=CC(=O)NCCCc1ccc(-c2ccc(-c3ccc(C4CCC(CCCCC)CC4)cc3)c(F)c2)cc1] |
| 1β-6-204 | 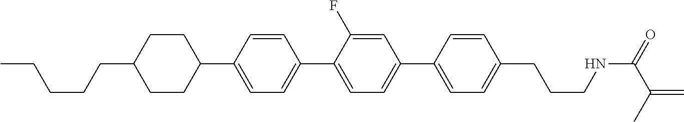 [SMILES: C=C(C)C(=O)NCCCc1ccc(-c2ccc(-c3ccc(C4CCC(CCCCC)CC4)cc3)c(F)c2)cc1] |
| 1β-6-205 | 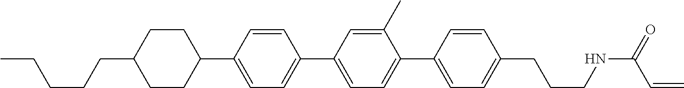 [SMILES: C=CC(=O)NCCCc1ccc(-c2ccc(-c3ccc(C4CCC(CCCCC)CC4)cc3)cc2C)cc1] |
| 1β-6-206 | 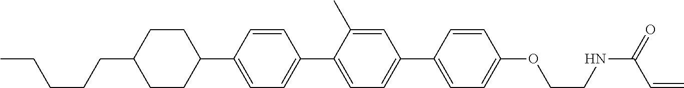 [SMILES: C=CC(=O)NCCOc1ccc(-c2ccc(-c3ccc(C4CCC(CCCCC)CC4)cc3)c(C)c2)cc1] |
| 1β-6-207 | 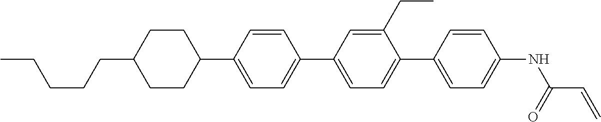 [SMILES: C=CC(=O)Nc1ccc(-c2ccc(-c3ccc(C4CCC(CCCCC)CC4)cc3)cc2CC)cc1] |
| 1β-6-208 | 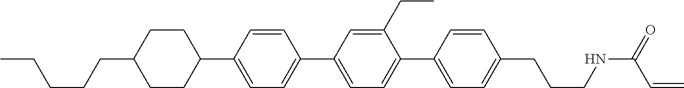 [SMILES: C=CC(=O)NCCCc1ccc(-c2ccc(-c3ccc(C4CCC(CCCCC)CC4)cc3)cc2CC)cc1] |
| 1β-6-209 | 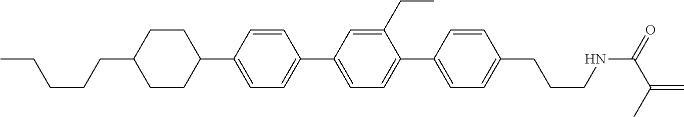 [SMILES: C=C(C)C(=O)NCCCc1ccc(-c2ccc(-c3ccc(C4CCC(CCCCC)CC4)cc3)cc2CC)cc1] |
| 1β-6-210 | 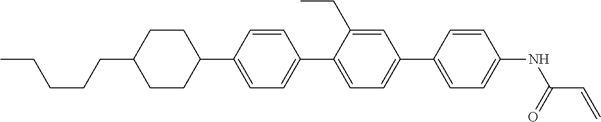 [SMILES: C=CC(=O)Nc1ccc(-c2ccc(-c3ccc(C4CCC(CCCCC)CC4)cc3)c(CC)c2)cc1] |
| 1β-6-211 | 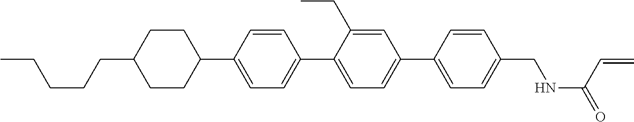 [SMILES: C=CC(=O)NCc1ccc(-c2ccc(-c3ccc(C4CCC(CCCCC)CC4)cc3)c(CC)c2)cc1] |
| 1β-6-212 | 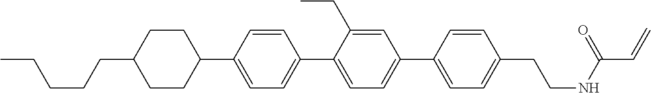 [SMILES: C=CC(=O)NCCc1ccc(-c2ccc(-c3ccc(C4CCC(CCCCC)CC4)cc3)c(CC)c2)cc1] |
| 1β-6-213 | 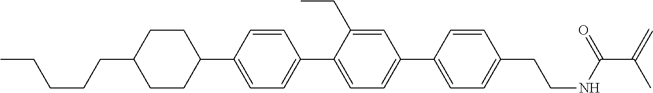 [SMILES: C=C(C)C(=O)NCCc1ccc(-c2ccc(-c3ccc(C4CCC(CCCCC)CC4)cc3)c(CC)c2)cc1] |
| 1β-6-214 | 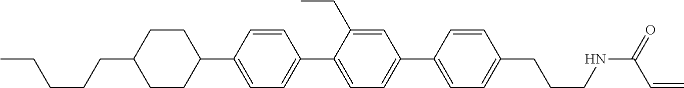 [SMILES: C=CC(=O)NCCCc1ccc(-c2ccc(-c3ccc(C4CCC(CCCCC)CC4)cc3)c(CC)c2)cc1] |
| 1β-6-215 | 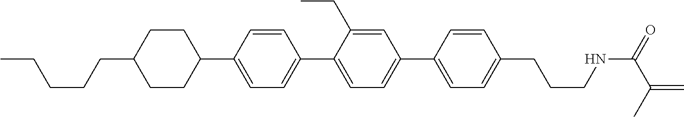 [SMILES: C=C(C)C(=O)NCCCc1ccc(-c2ccc(-c3ccc(C4CCC(CCCCC)CC4)cc3)c(CC)c2)cc1] |
| 1β-6-216 | 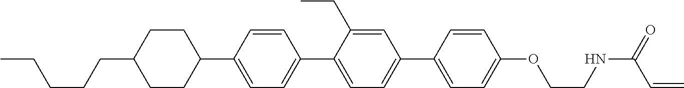 [SMILES: C=CC(=O)NCCOc1ccc(-c2ccc(-c3ccc(C4CCC(CCCCC)CC4)cc3)c(CC)c2)cc1] |
| 1β-6-217 | 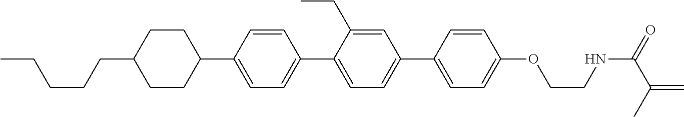 [SMILES: C=C(C)C(=O)NCCOc1ccc(-c2ccc(-c3ccc(C4CCC(CCCCC)CC4)cc3)c(CC)c2)cc1] |
| 1β-6-218 | 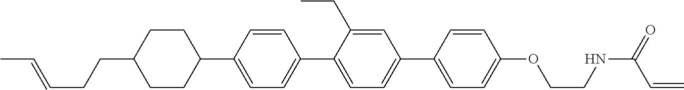 [SMILES: C=CC(=O)NCCOc1ccc(-c2ccc(-c3ccc(C4CCC(CC/C=C/C)CC4)cc3)c(CC)c2)cc1] |
| 1β-6-219 | 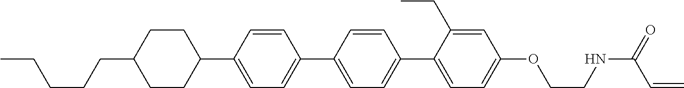 [SMILES: C=CC(=O)NCCOc1ccc(-c2ccc(-c3ccc(C4CCC(CCCCC)CC4)cc3)cc2)c(CC)c1] |
| 1β-6-220 | 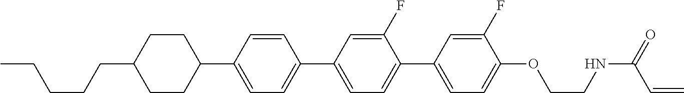 [SMILES: C=CC(=O)NCCOc1ccc(-c2ccc(-c3ccc(C4CCC(CCCCC)CC4)cc3)cc2F)cc1F] |
| 1β-6-221 | 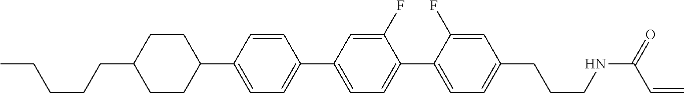 [SMILES: C=CC(=O)NCCCc1ccc(-c2ccc(-c3ccc(C4CCC(CCCCC)CC4)cc3)cc2F)c(F)c1] |
| 1β-6-222 | 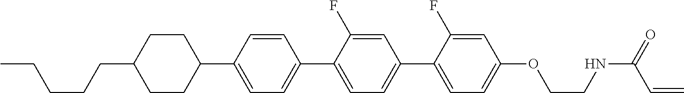 [SMILES: C=CC(=O)NCCOc1ccc(-c2ccc(-c3ccc(C4CCC(CCCCC)CC4)cc3)c(F)c2)c(F)c1] |
| 1β-6-223 | 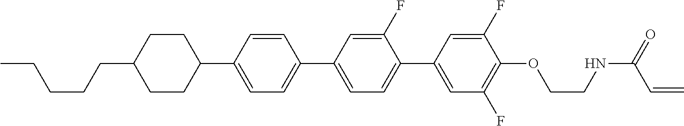 [SMILES: C=CC(=O)NCCOc1c(F)cc(-c2ccc(-c3ccc(C4CCC(CCCCC)CC4)cc3)cc2F)cc1F] |
| 1β-6-224 | 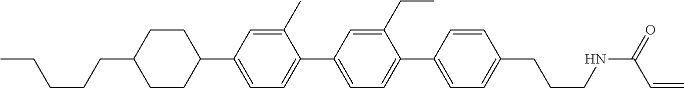 [SMILES: C=CC(=O)NCCCc1ccc(-c2ccc(-c3ccc(C4CCC(CCCCC)CC4)cc3C)cc2CC)cc1] |
| 1β-6-225 | 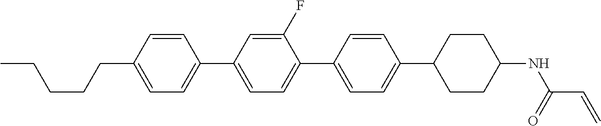 [SMILES: C=CC(=O)NC1CCC(c2ccc(-c3ccc(-c4ccc(CCCCC)cc4)cc3F)cc2)CC1] |
| 1β-6-226 | 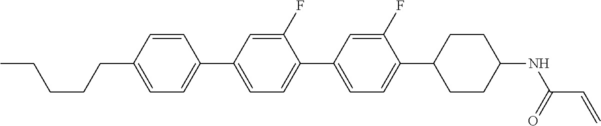 [SMILES: C=CC(=O)NC1CCC(c2ccc(-c3ccc(-c4ccc(CCCCC)cc4)cc3F)cc2F)CC1] |
| 1β-6-227 | 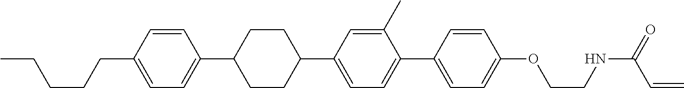 [SMILES: C=CC(=O)NCCOc1ccc(-c2ccc(C3CCC(c4ccc(CCCCC)cc4)CC3)cc2C)cc1] |
| 1β-6-228 | 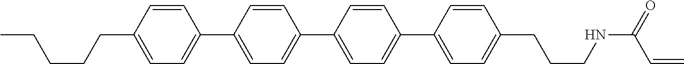 [SMILES: C=CC(=O)NCCCc1ccc(-c2ccc(-c3ccc(-c4ccc(CCCCC)cc4)cc3)cc2)cc1] |
| 1β-6-229 | 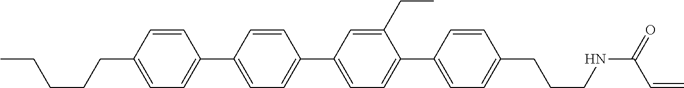 [SMILES: C=CC(=O)NCCCc1ccc(-c2ccc(-c3ccc(-c4ccc(CCCCC)cc4)cc3)cc2CC)cc1] |
| 1β-6-230 | 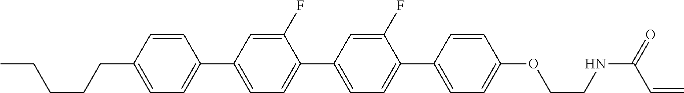 [SMILES: C=CC(=O)NCCOc1ccc(-c2ccc(-c3ccc(-c4ccc(CCCCC)cc4)cc3F)cc2F)cc1] |
| 1β-6-231 | 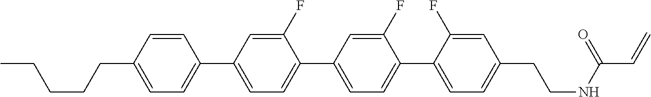 [SMILES: C=CC(=O)NCCc1ccc(-c2ccc(-c3ccc(-c4ccc(CCCCC)cc4)cc3F)cc2F)c(F)c1] |
| 1β-6-232 | 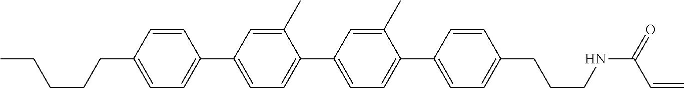 [SMILES: C=CC(=O)NCCCc1ccc(-c2ccc(-c3ccc(-c4ccc(CCCCC)cc4)cc3C)cc2C)cc1] |
| 1β-6-233 | 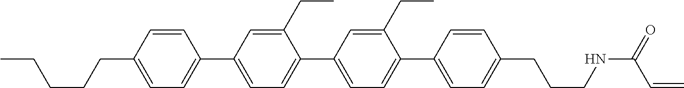 [SMILES: C=CC(=O)NCCCc1ccc(-c2ccc(-c3ccc(-c4ccc(CCCCC)cc4)cc3CC)cc2CC)cc1] |
| 1β-6-234 | 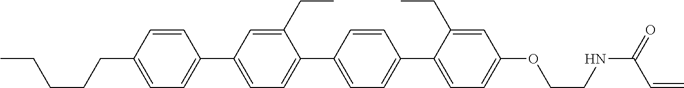 [SMILES: C=CC(=O)NCCOc1ccc(-c2ccc(-c3ccc(-c4ccc(CCCCC)cc4)cc3CC)cc2)c(CC)c1] |
| 1β-6-235 | 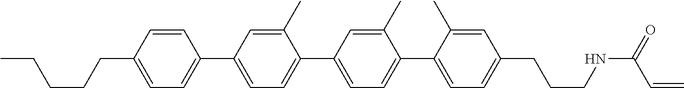 [SMILES: C=CC(=O)NCCCc1ccc(-c2ccc(-c3ccc(-c4ccc(CCCCC)cc4)cc3C)cc2C)c(C)c1] |
| 1β-6-236 | 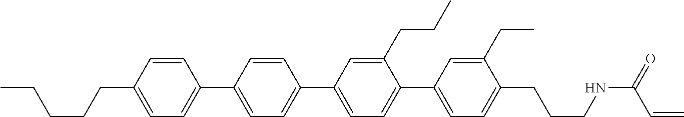 [SMILES: C=CC(=O)NCCCc1ccc(-c2ccc(-c3ccc(-c4ccc(CCCCC)cc4)cc3)cc2CCC)cc1CC] |
| 1β-6-237 | 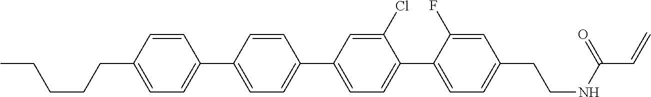 [SMILES: C=CC(=O)NCCc1ccc(-c2ccc(-c3ccc(-c4ccc(CCCCC)cc4)cc3)cc2Cl)c(F)c1] |
| 1β-6-238 | 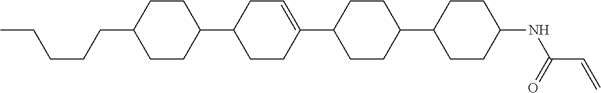 [SMILES: C=CC(=O)NC1CCC(C2CCC(C3=CCC(C4CCC(CCCCC)CC4)CC3)CC2)CC1] |
| 1β-6-239 | 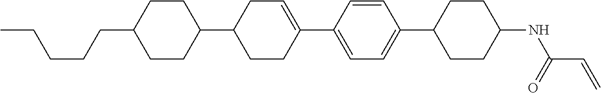 [SMILES: C=CC(=O)NC1CCC(c2ccc(C3=CCC(C4CCC(CCCCC)CC4)CC3)cc2)CC1] |
| 1β-6-240 | 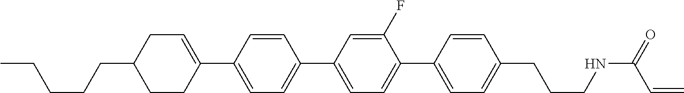 [SMILES: C=CC(=O)NCCCc1ccc(-c2ccc(-c3ccc(C4=CCC(CCCCC)CC4)cc3)cc2F)cc1] |
| 1β-6-241 | 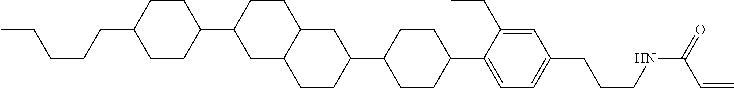 [SMILES: C=CC(=O)NCCCc1ccc(C2CCC(C3CCC4CC(C5CCC(CCCCC)CC5)CCC4C3)CC2)c(CC)c1] |
| 1β-6-242 | 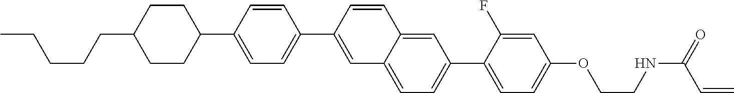 [SMILES: C=CC(=O)NCCOc1ccc(-c2ccc3cc(-c4ccc(C5CCC(CCCCC)CC5)cc4)ccc3c2)c(F)c1] |
| 1β-6-243 | 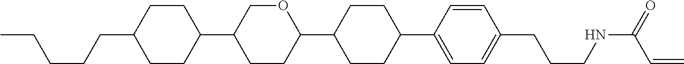 [SMILES: C=CC(=O)NCCCc1ccc(C2CCC(C3CCC(C4CCC(CCCCC)CC4)CO3)CC2)cc1] |
| 1β-6-244 | 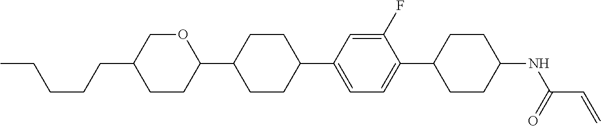 [SMILES: C=CC(=O)NC1CCC(c2ccc(C3CCC(C4CCC(CCCCC)CO4)CC3)cc2F)CC1] |
| 1β-6-245 | 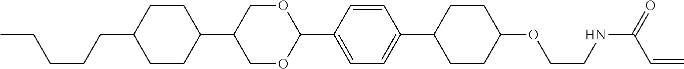 [SMILES: C=CC(=O)NCCOC1CCC(c2ccc(C3OCC(C4CCC(CCCCC)CC4)CO3)cc2)CC1] |
| 1β-6-246 | 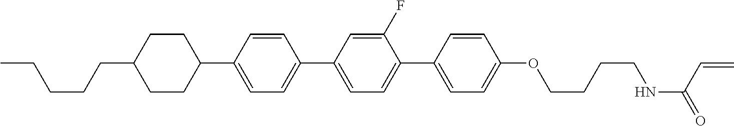 [SMILES: C=CC(=O)NCCCCOc1ccc(-c2ccc(-c3ccc(C4CCC(CCCCC)CC4)cc3)cc2F)cc1] |
| 1β-6-247 | 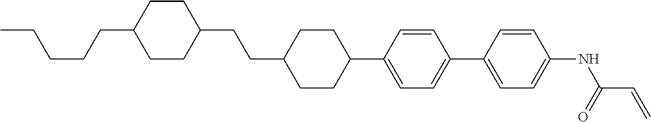 [SMILES: C=CC(=O)Nc1ccc(-c2ccc(C3CCC(CCC4CCC(CCCCC)CC4)CC3)cc2)cc1] |
| 1β-6-248 | 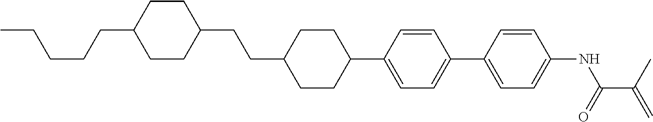 [SMILES: C=C(C)C(=O)Nc1ccc(-c2ccc(C3CCC(CCC4CCC(CCCCC)CC4)CC3)cc2)cc1] |
| 1β-6-249 | 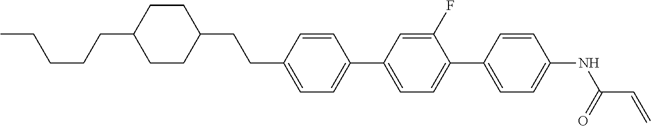 [SMILES: C=CC(=O)Nc1ccc(-c2ccc(-c3ccc(CCC4CCC(CCCCC)CC4)cc3)cc2F)cc1] |
| 1β-6-250 | 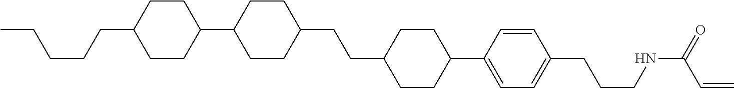 [SMILES: C=CC(=O)NCCCc1ccc(C2CCC(CCC3CCC(C4CCC(CCCCC)CC4)CC3)CC2)cc1] |
| 1β-6-251 | 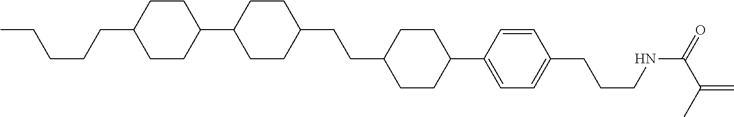 [SMILES: C=C(C)C(=O)NCCCc1ccc(C2CCC(CCC3CCC(C4CCC(CCCCC)CC4)CC3)CC2)cc1] |
| 1β-6-252 | 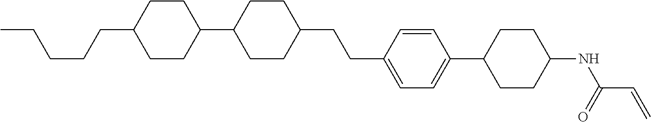 [SMILES: C=CC(=O)NC1CCC(c2ccc(CCC3CCC(C4CCC(CCCCC)CC4)CC3)cc2)CC1] |
| 1β-6-253 | 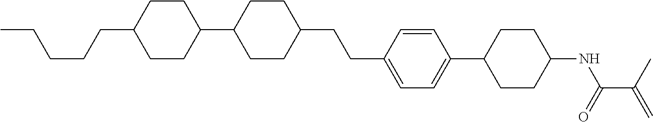 [SMILES: C=C(C)C(=O)NC1CCC(c2ccc(CCC3CCC(C4CCC(CCCCC)CC4)CC3)cc2)CC1] |
| 1β-6-254 | 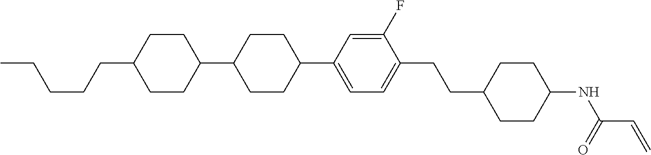 [SMILES: C=CC(=O)NC1CCC(CCc2ccc(C3CCC(C4CCC(CCCCC)CC4)CC3)cc2F)CC1] |
| 1β-6-255 | 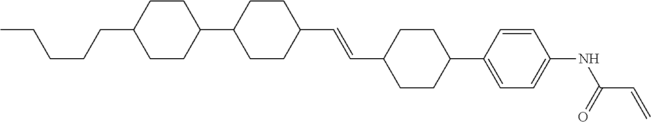 [SMILES: C=CC(=O)Nc1ccc(C2CCC(/C=C/C3CCC(C4CCC(CCCCC)CC4)CC3)CC2)cc1] |
| 1β-6-256 | 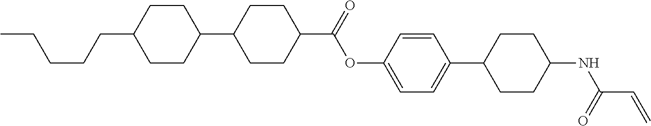 [SMILES: C=CC(=O)NC1CCC(c2ccc(OC(=O)C3CCC(C4CCC(CCCCC)CC4)CC3)cc2)CC1] |
| 1β-6-257 | 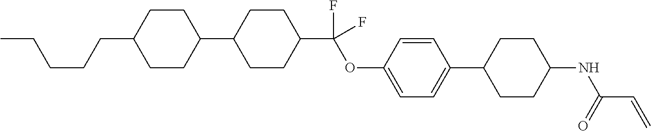 [SMILES: C=CC(=O)NC1CCC(c2ccc(OC(F)(F)C3CCC(C4CCC(CCCCC)CC4)CC3)cc2)CC1] |
| 1β-6-258 | 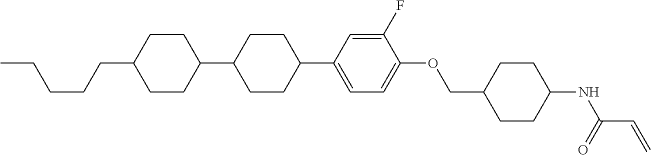 [SMILES: C=CC(=O)NC1CCC(COc2ccc(C3CCC(C4CCC(CCCCC)CC4)CC3)cc2F)CC1] |

### 16. Example of Compound (1γ)

According to the synthesis methods described in Synthesis Examples, compounds (1γ-1-1) to (1γ-1-80), compounds (1γ-2-1) to (1γ-2-225), compounds (1γ-3-1) to (1γ-3-100), compounds (1γ-4-1) to (1γ-4-70), compounds (1γ-5-1) to (1γ-5-75) and compounds (1γ-6-1) to (1γ-6-60) shown below can be prepared.

No.

| | |
|---|---|
| 1γ-1-1 | 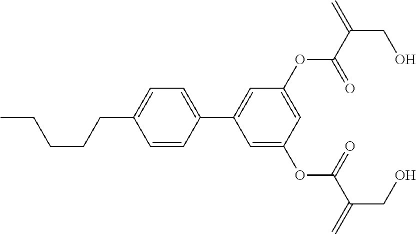 [SMILES: C=C(CO)C(=O)Oc1cc(OC(=O)C(=C)CO)cc(-c2ccc(CCCCC)cc2)c1] |
| 1γ-1-2 | 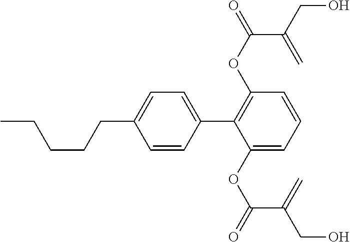 [SMILES: C=C(CO)C(=O)Oc1cccc(OC(=O)C(=C)CO)c1-c1ccc(CCCCC)cc1] |
| 1γ-1-3 | 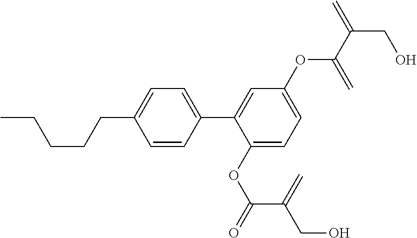 [SMILES: C=C(CO)C(=C)Oc1ccc(OC(=O)C(=C)CO)c(-c2ccc(CCCCC)cc2)c1] |
| 1γ-1-4 | 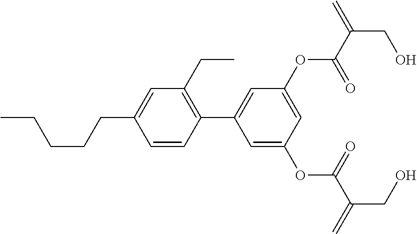 [SMILES: C=C(CO)C(=O)Oc1cc(OC(=O)C(=C)CO)cc(-c2ccc(CCCCC)cc2CC)c1] |
| 1γ-1-5 | 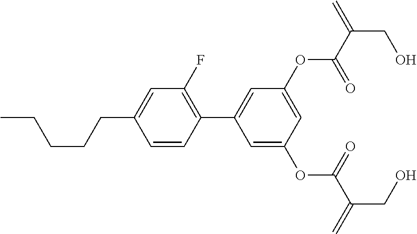 [SMILES: C=C(CO)C(=O)Oc1cc(OC(=O)C(=C)CO)cc(-c2ccc(CCCCC)cc2F)c1] |
| 1γ-1-6 | 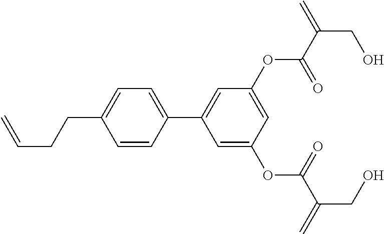 [SMILES: C=CCCc1ccc(-c2cc(OC(=O)C(=C)CO)cc(OC(=O)C(=C)CO)c2)cc1] |
| 1γ-1-7 | 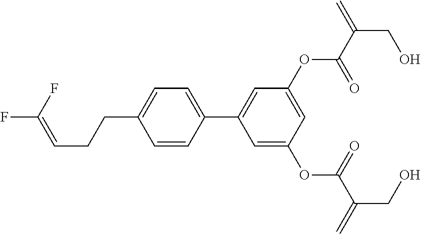 [SMILES: C=C(CO)C(=O)Oc1cc(OC(=O)C(=C)CO)cc(-c2ccc(CCC=C(F)F)cc2)c1] |
| 1γ-1-8 | 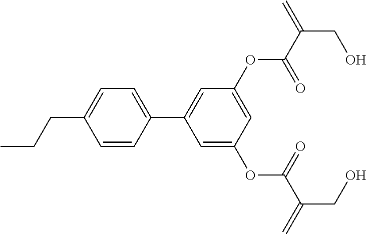 [SMILES: C=C(CO)C(=O)Oc1cc(OC(=O)C(=C)CO)cc(-c2ccc(CCC)cc2)c1] |
| 1γ-1-9 | 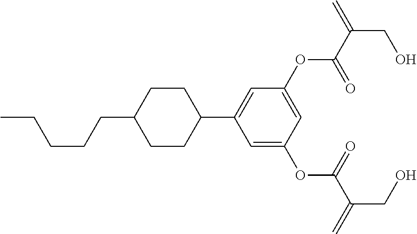 [SMILES: C=C(CO)C(=O)Oc1cc(OC(=O)C(=C)CO)cc(C2CCC(CCCCC)CC2)c1] |
| 1γ-1-10 | 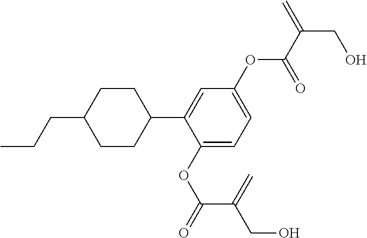 [SMILES: C=C(CO)C(=O)Oc1ccc(OC(=O)C(=C)CO)c(C2CCC(CCC)CC2)c1] |
| 1γ-1-11 | 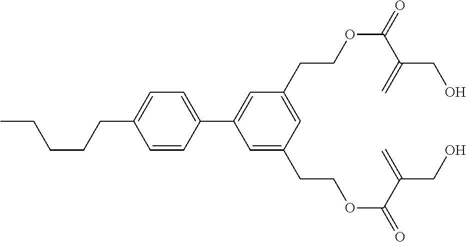 [SMILES: C=C(CO)C(=O)OCCc1cc(CCOC(=O)C(=C)CO)cc(-c2ccc(CCCCC)cc2)c1] |
| 1γ-1-12 | 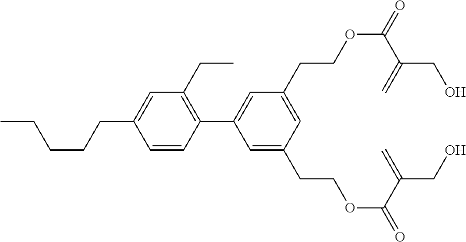 [SMILES: C=C(CO)C(=O)OCCc1cc(CCOC(=O)C(=C)CO)cc(-c2ccc(CCCCC)cc2CC)c1] |
| 1γ-1-13 | 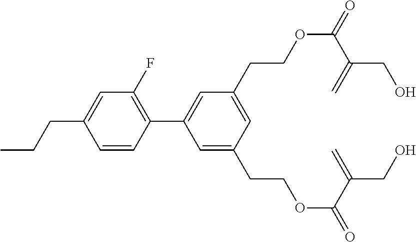 [SMILES: C=C(CO)C(=O)OCCc1cc(CCOC(=O)C(=C)CO)cc(-c2ccc(CCC)cc2F)c1] |
| 1γ-1-14 | 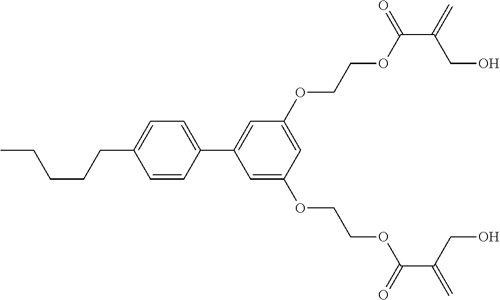 [SMILES: C=C(CO)C(=O)OCCOc1cc(OCCOC(=O)C(=C)CO)cc(-c2ccc(CCCCC)cc2)c1] |
| 1γ-1-15 | 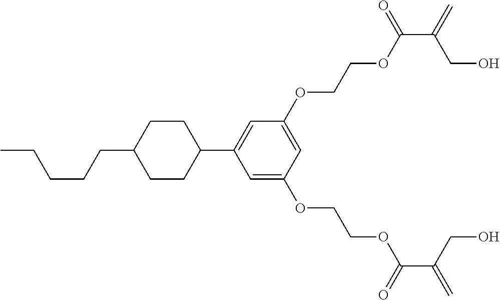 [SMILES: C=C(CO)C(=O)OCCOc1cc(OCCOC(=O)C(=C)CO)cc(C2CCC(CCCCC)CC2)c1] |
| 1γ-1-16 | 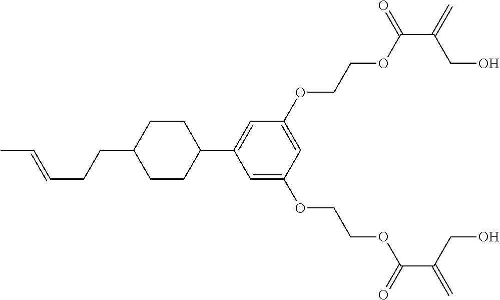 [SMILES: C=C(CO)C(=O)OCCOc1cc(OCCOC(=O)C(=C)CO)cc(C2CCC(CC/C=C/C)CC2)c1] |
| 1γ-1-17 | 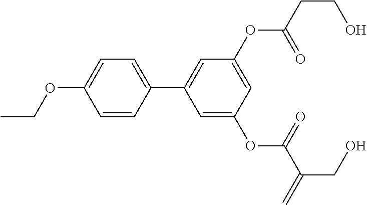 [SMILES: C=C(CO)C(=O)Oc1cc(OC(=O)CCO)cc(-c2ccc(OCC)cc2)c1] |
| 1γ-1-18 | 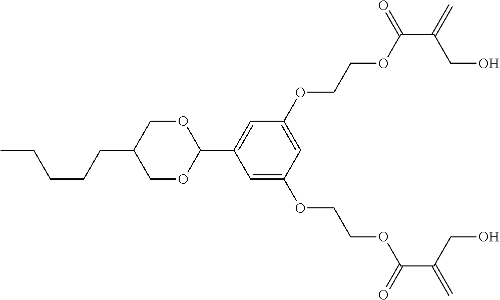 [SMILES: C=C(CO)C(=O)OCCOc1cc(OCCOC(=O)C(=C)CO)cc(C2OCC(CCCCC)CO2)c1] |
| 1γ-1-19 | 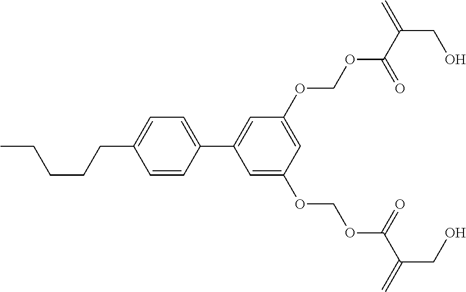 [SMILES: C=C(CO)C(=O)OCOc1cc(OCOC(=O)C(=C)CO)cc(-c2ccc(CCCCC)cc2)c1] |
| 1γ-1-20 | 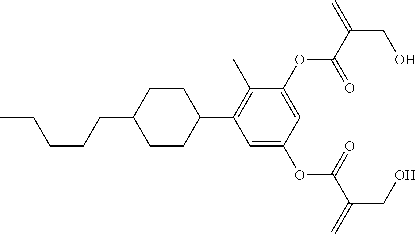 [SMILES: C=C(CO)C(=O)Oc1cc(OC(=O)C(=C)CO)c(C)c(C2CCC(CCCCC)CC2)c1] |
| 1γ-1-21 | 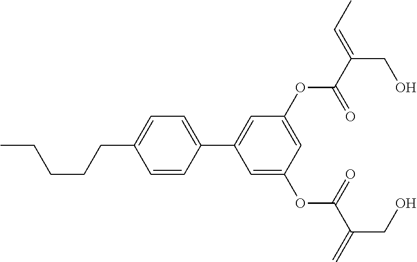 [SMILES: C=C(CO)C(=O)Oc1cc(OC(=O)/C(=C/C)CO)cc(-c2ccc(CCCCC)cc2)c1] |
| 1γ-1-22 | 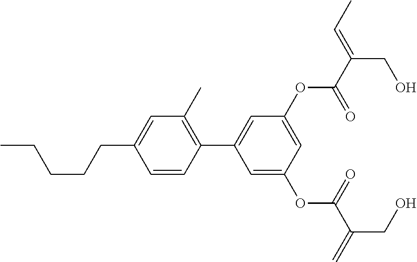 [SMILES: C=C(CO)C(=O)Oc1cc(OC(=O)/C(=C/C)CO)cc(-c2ccc(CCCCC)cc2C)c1] |
| 1γ-1-23 | 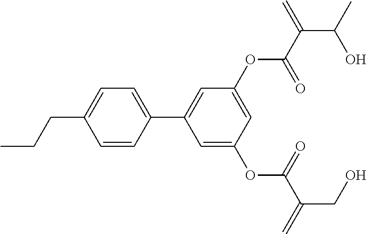 [SMILES: C=C(CO)C(=O)Oc1cc(OC(=O)C(=C)C(C)O)cc(-c2ccc(CCC)cc2)c1] |
| 1γ-1-24 | 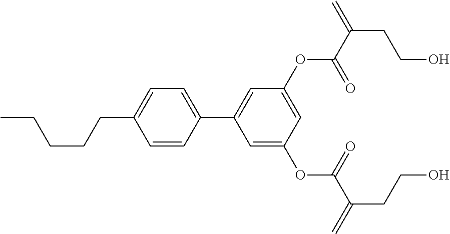 [SMILES: C=C(CCO)C(=O)Oc1cc(OC(=O)C(=C)CCO)cc(-c2ccc(CCCCC)cc2)c1] |
| 1γ-1-25 | 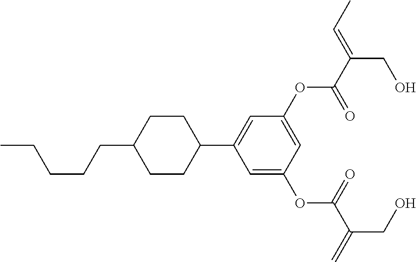 [SMILES: C=C(CO)C(=O)Oc1cc(OC(=O)/C(=C/C)CO)cc(C2CCC(CCCCC)CC2)c1] |
| 1γ-1-26 | 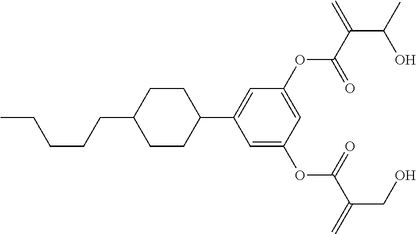 [SMILES: C=C(CO)C(=O)Oc1cc(OC(=O)C(=C)C(C)O)cc(C2CCC(CCCCC)CC2)c1] |
| 1γ-1-27 | 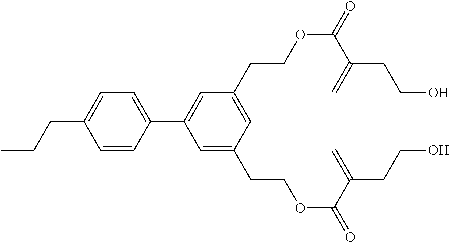 [SMILES: C=C(CCO)C(=O)OCCc1cc(CCOC(=O)C(=C)CCO)cc(-c2ccc(CCC)cc2)c1] |
| 1γ-1-28 | 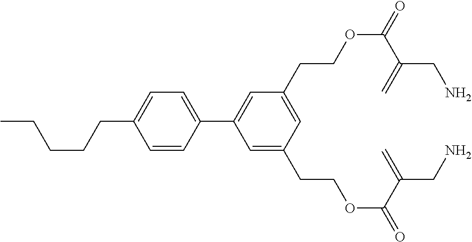 [SMILES: C=C(CN)C(=O)OCCc1cc(CCOC(=O)C(=C)CN)cc(-c2ccc(CCCCC)cc2)c1] |
| 1γ-1-29 | 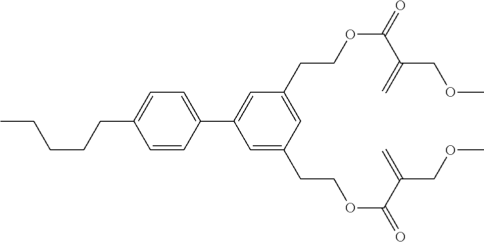 [SMILES: C=C(COC)C(=O)OCCc1cc(CCOC(=O)C(=C)COC)cc(-c2ccc(CCCCC)cc2)c1] |
| 1γ-1-30 | 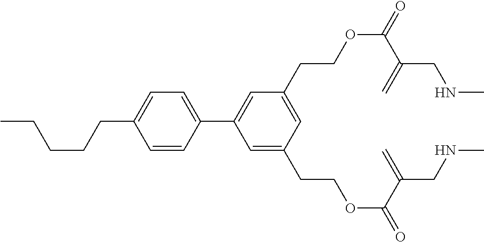 [SMILES: C=C(CNC)C(=O)OCCc1cc(CCOC(=O)C(=C)CNC)cc(-c2ccc(CCCCC)cc2)c1] |
| 1γ-1-31 | 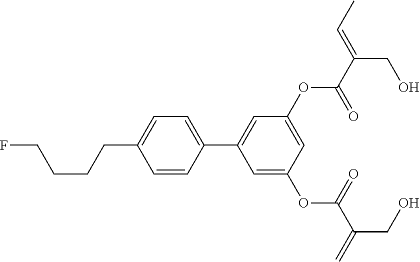 [SMILES: C=C(CO)C(=O)Oc1cc(OC(=O)/C(=C/C)CO)cc(-c2ccc(CCCCF)cc2)c1] |
| 1γ-1-32 | 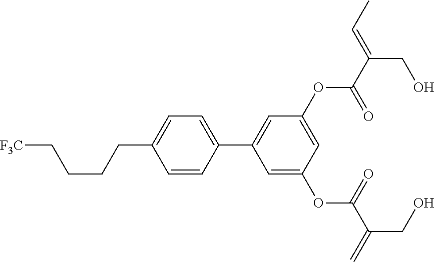 [SMILES: C=C(CO)C(=O)Oc1cc(OC(=O)/C(=C/C)CO)cc(-c2ccc(CCCCC(F)(F)F)cc2)c1] |
| 1γ-1-33 | 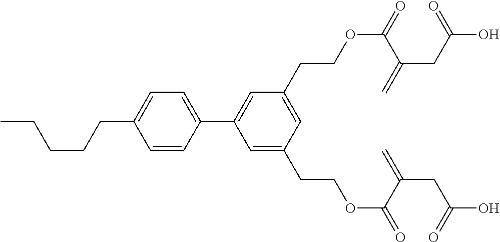 [SMILES: C=C(CC(=O)O)C(=O)OCCc1cc(CCOC(=O)C(=C)CC(=O)O)cc(-c2ccc(CCCCC)cc2)c1] |
| 1γ-1-34 | 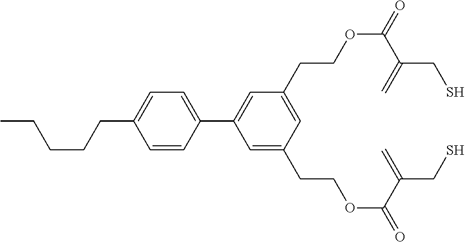 [SMILES: C=C(CS)C(=O)OCCc1cc(CCOC(=O)C(=C)CS)cc(-c2ccc(CCCCC)cc2)c1] |
| 1γ-1-35 | 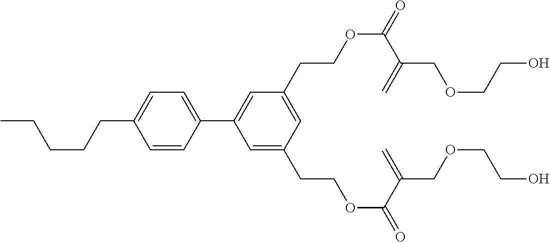 [SMILES: C=C(COCCO)C(=O)OCCc1cc(CCOC(=O)C(=C)COCCO)cc(-c2ccc(CCCCC)cc2)c1] |
| 1γ-1-36 | 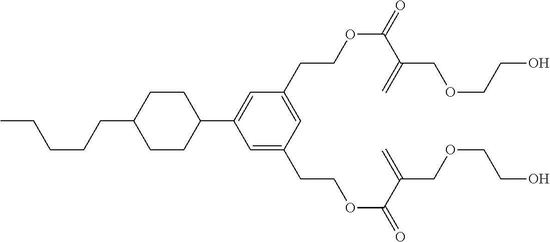 [SMILES: C=C(COCCO)C(=O)OCCc1cc(CCOC(=O)C(=C)COCCO)cc(C2CCC(CCCCC)CC2)c1] |
| 1γ-1-37 | 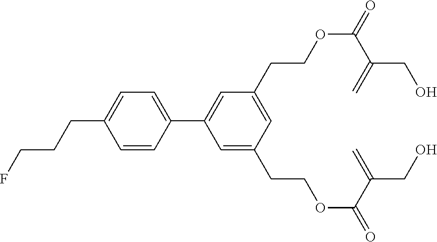 [SMILES: C=C(CO)C(=O)OCCc1cc(CCOC(=O)C(=C)CO)cc(-c2ccc(CCCF)cc2)c1] |
| 1γ-1-38 | 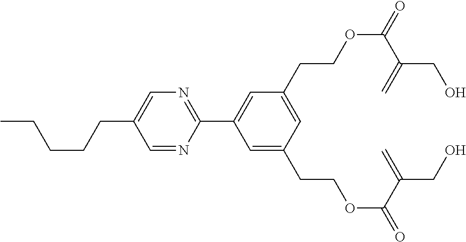 [SMILES: C=C(CO)C(=O)OCCc1cc(CCOC(=O)C(=C)CO)cc(-c2ncc(CCCCC)cn2)c1] |
| 1γ-1-39 | 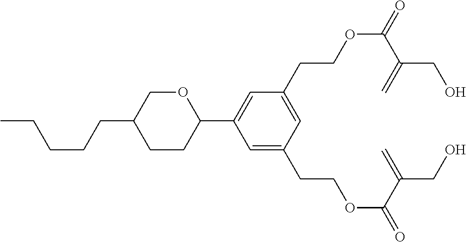 [SMILES: C=C(CO)C(=O)OCCc1cc(CCOC(=O)C(=C)CO)cc(C2CCC(CCCCC)CO2)c1] |
| 1γ-1-40 | 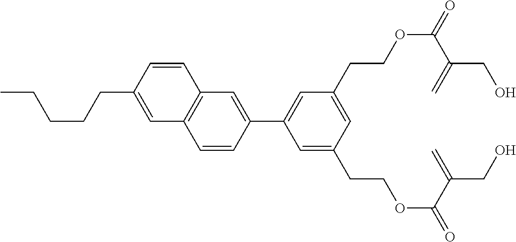 [SMILES: C=C(CO)C(=O)OCCc1cc(CCOC(=O)C(=C)CO)cc(-c2ccc3cc(CCCCC)ccc3c2)c1] |
| 1γ-1-41 | 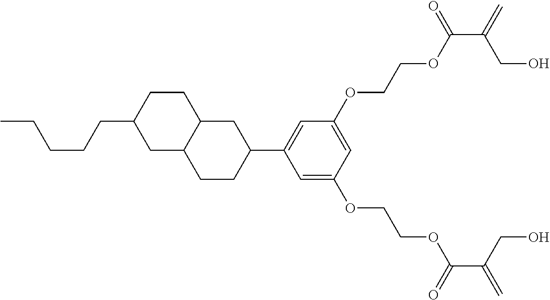 [SMILES: C=C(CO)C(=O)OCCOc1cc(OCCOC(=O)C(=C)CO)cc(C2CCC3CC(CCCCC)CCC3C2)c1] |
| 1γ-1-42 | 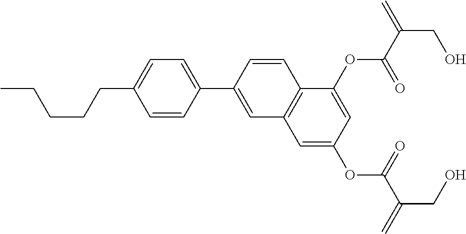 [SMILES: C=C(CO)C(=O)Oc1cc(OC(=O)C(=C)CO)c2ccc(-c3ccc(CCCCC)cc3)cc2c1] |
| 1γ-1-43 | 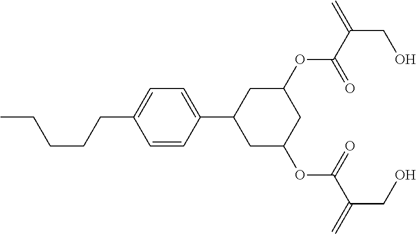 [SMILES: C=C(CO)C(=O)OC1CC(OC(=O)C(=C)CO)CC(c2ccc(CCCCC)cc2)C1] |
| 1γ-1-44 | 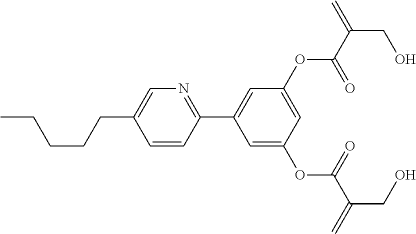 [SMILES: C=C(CO)C(=O)Oc1cc(OC(=O)C(=C)CO)cc(-c2ccc(CCCCC)cn2)c1] |
| 1γ-1-45 | 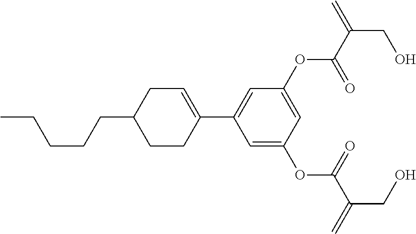 [SMILES: C=C(CO)C(=O)Oc1cc(OC(=O)C(=C)CO)cc(C2=CCC(CCCCC)CC2)c1] |
| 1γ-1-46 | 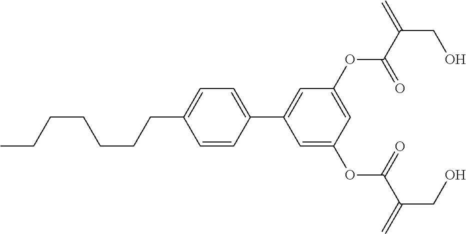 [SMILES: C=C(CO)C(=O)Oc1cc(OC(=O)C(=C)CO)cc(-c2ccc(CCCCCCC)cc2)c1] |
| 1γ-1-47 | 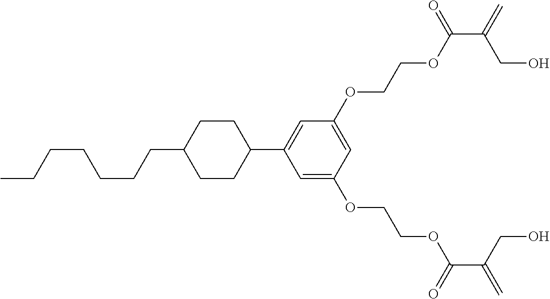 [SMILES: C=C(CO)C(=O)OCCOc1cc(OCCOC(=O)C(=C)CO)cc(C2CCC(CCCCCCC)CC2)c1] |
| 1γ-1-48 | 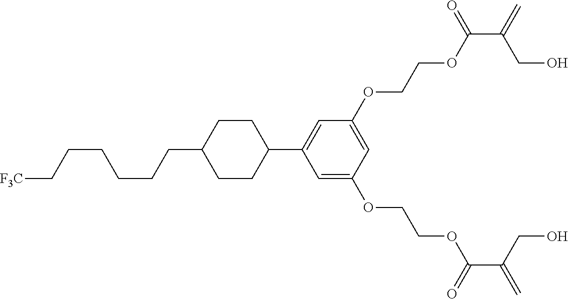 [SMILES: C=C(CO)C(=O)OCCOc1cc(OCCOC(=O)C(=C)CO)cc(C2CCC(CCCCCCC(F)(F)F)CC2)c1] |
| 1γ-1-49 | 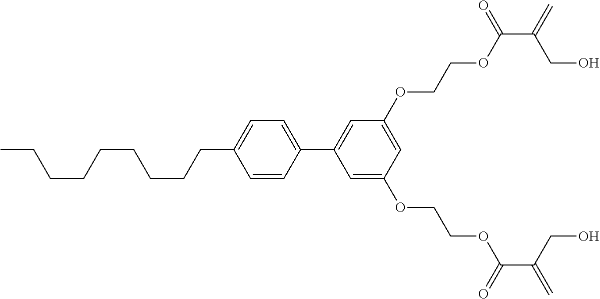 [SMILES: C=C(CO)C(=O)OCCOc1cc(OCCOC(=O)C(=C)CO)cc(-c2ccc(CCCCCCCCC)cc2)c1] |
| 1γ-1-50 | 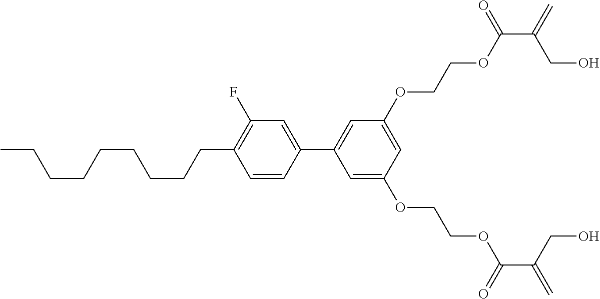 [SMILES: C=C(CO)C(=O)OCCOc1cc(OCCOC(=O)C(=C)CO)cc(-c2ccc(CCCCCCCCC)c(F)c2)c1] |
| 1γ-1-51 | 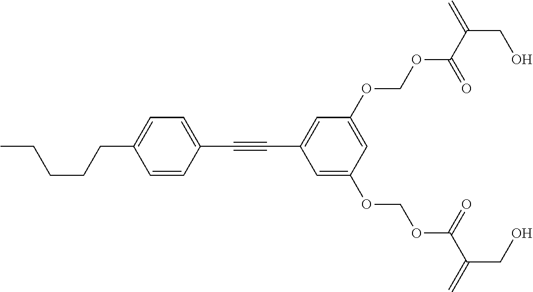 [SMILES: C=C(CO)C(=O)OCOc1cc(C#Cc2ccc(CCCCC)cc2)cc(OCOC(=O)C(=C)CO)c1] |
| 1γ-1-52 | 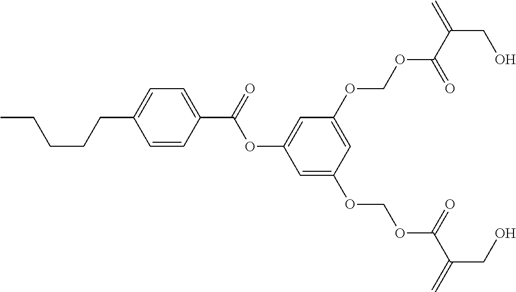 [SMILES: C=C(CO)C(=O)OCOc1cc(OCOC(=O)C(=C)CO)cc(OC(=O)c2ccc(CCCCC)cc2)c1] |
| 1γ-1-53 | 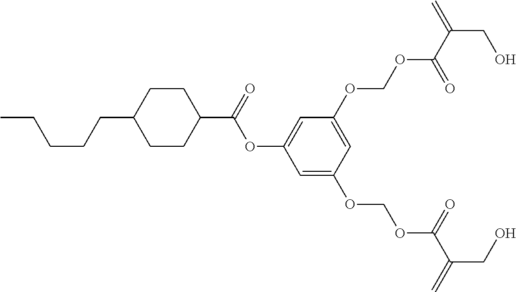 [SMILES: C=C(CO)C(=O)OCOc1cc(OCOC(=O)C(=C)CO)cc(OC(=O)C2CCC(CCCCC)CC2)c1] |
| 1γ-1-54 | 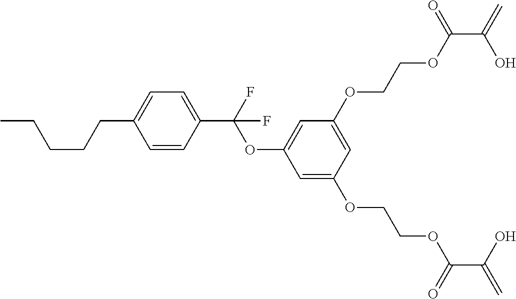 [SMILES: C=C(O)C(=O)OCCOc1cc(OCCOC(=O)C(=C)O)cc(OC(F)(F)c2ccc(CCCCC)cc2)c1] |
| 1γ-1-55 | 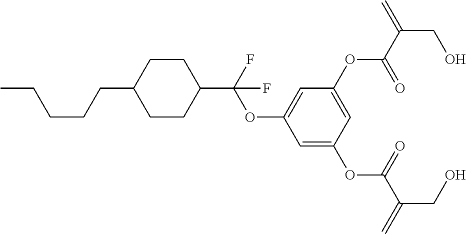 [SMILES: C=C(CO)C(=O)Oc1cc(OC(=O)C(=C)CO)cc(OC(F)(F)C2CCC(CCCCC)CC2)c1] |
| 1γ-1-56 | 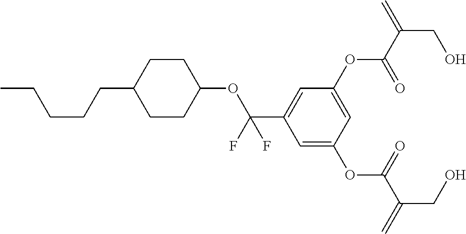 [SMILES: C=C(CO)C(=O)Oc1cc(OC(=O)C(=C)CO)cc(C(F)(F)OC2CCC(CCCCC)CC2)c1] |
| 1γ-1-57 | 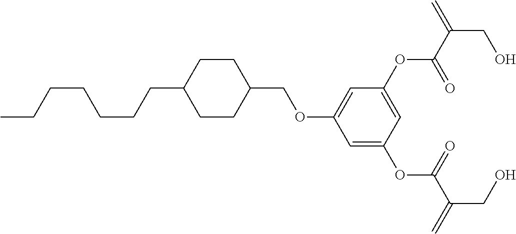 [SMILES: C=C(CO)C(=O)Oc1cc(OCC2CCC(CCCCCCC)CC2)cc(OC(=O)C(=C)CO)c1] |
| 1γ-1-58 | 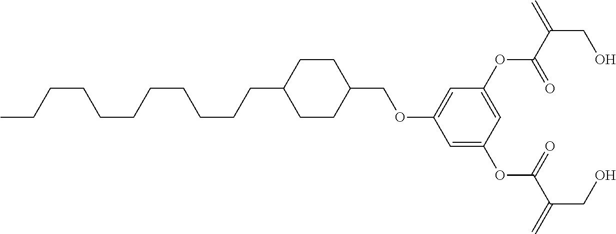 [SMILES: C=C(CO)C(=O)Oc1cc(OCC2CCC(CCCCCCCCCCC)CC2)cc(OC(=O)C(=C)CO)c1] |
| 1γ-1-59 | 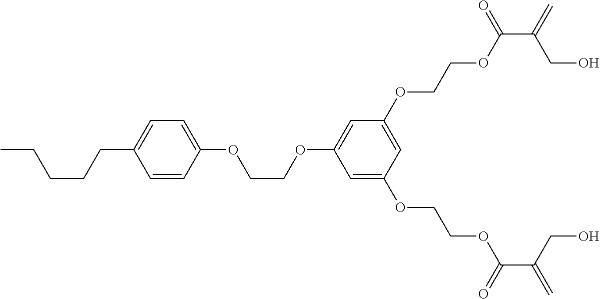 [SMILES: C=C(CO)C(=O)OCCOc1cc(OCCOC(=O)C(=C)CO)cc(OCCOc2ccc(CCCCC)cc2)c1] |
| 1γ-1-60 | 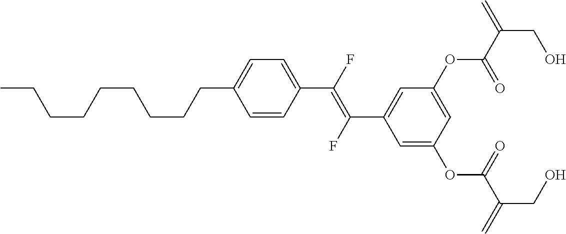 [SMILES: C=C(CO)C(=O)Oc1cc(OC(=O)C(=C)CO)cc(/C(F)=C(\F)c2ccc(CCCCCCCCC)cc2)c1] |
| 1γ-1-61 | 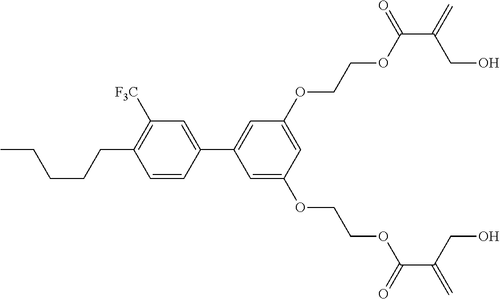 [SMILES: C=C(CO)C(=O)OCCOc1cc(OCCOC(=O)C(=C)CO)cc(-c2ccc(CCCCC)c(C(F)(F)F)c2)c1] |
| 1γ-1-62 | 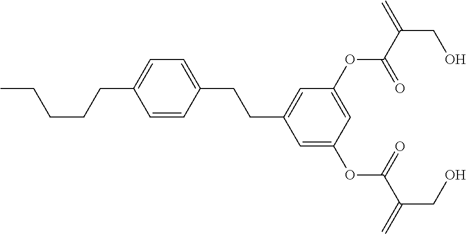 [SMILES: C=C(CO)C(=O)Oc1cc(CCc2ccc(CCCCC)cc2)cc(OC(=O)C(=C)CO)c1] |
| 1γ-1-63 | 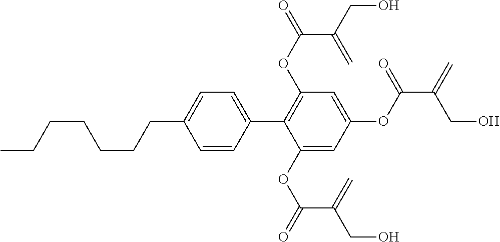 [SMILES: C=C(CO)C(=O)Oc1cc(OC(=O)C(=C)CO)c(-c2ccc(CCCCCCC)cc2)c(OC(=O)C(=C)CO)c1] |
| 1γ-1-64 | 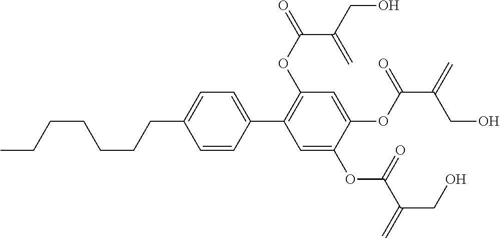 [SMILES: C=C(CO)C(=O)Oc1cc(OC(=O)C(=C)CO)c(-c2ccc(CCCCCCC)cc2)cc1OC(=O)C(=C)CO] |
| 1γ-1-65 | 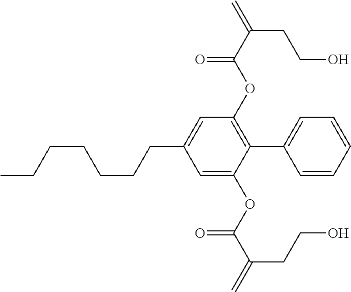 [SMILES: C=C(CCO)C(=O)Oc1cc(CCCCCCC)cc(OC(=O)C(=C)CCO)c1-c1ccccc1] |
| 1γ-1-66 | 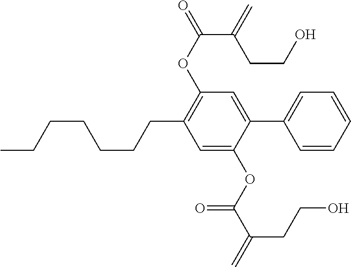 [SMILES: C=C(CCO)C(=O)Oc1cc(-c2ccccc2)c(OC(=O)C(=C)CCO)cc1CCCCCCC] |
| 1γ-1-67 | 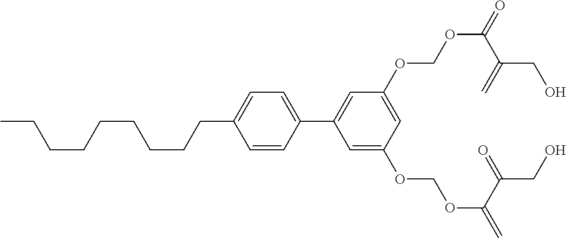 [SMILES: C=C(CO)C(=O)OCOc1cc(OCOC(=C)C(=O)CO)cc(-c2ccc(CCCCCCCCC)cc2)c1] |
| 1γ-1-68 | 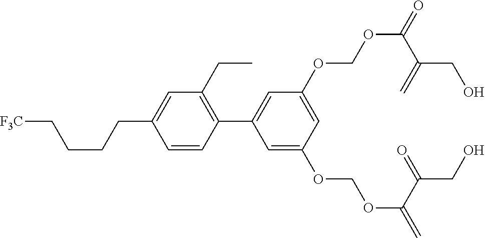 [SMILES: C=C(CO)C(=O)OCOc1cc(OCOC(=C)C(=O)CO)cc(-c2ccc(CCCCC(F)(F)F)cc2CC)c1] |
| 1γ-1-69 | 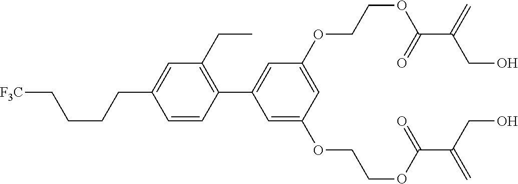 [SMILES: C=C(CO)C(=O)OCCOc1cc(OCCOC(=O)C(=C)CO)cc(-c2ccc(CCCCC(F)(F)F)cc2CC)c1] |
| 1γ-1-70 | 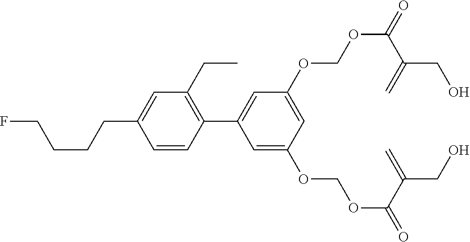 [SMILES: C=C(CO)C(=O)OCOc1cc(OCOC(=O)C(=C)CO)cc(-c2ccc(CCCCF)cc2CC)c1] |
| 1γ-1-71 | 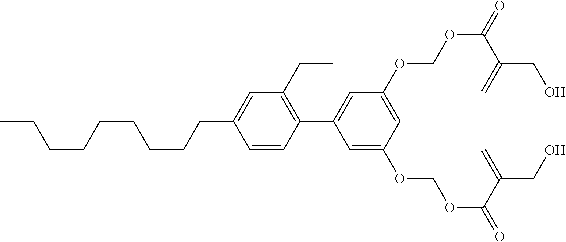 [SMILES: C=C(CO)C(=O)OCOc1cc(OCOC(=O)C(=C)CO)cc(-c2ccc(CCCCCCCCC)cc2CC)c1] |
| 1γ-1-72 | 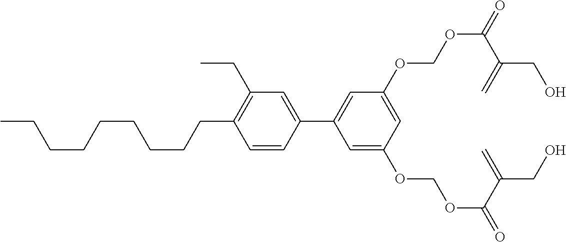 [SMILES: C=C(CO)C(=O)OCOc1cc(OCOC(=O)C(=C)CO)cc(-c2ccc(CCCCCCCCC)c(CC)c2)c1] |
| 1γ-1-73 | 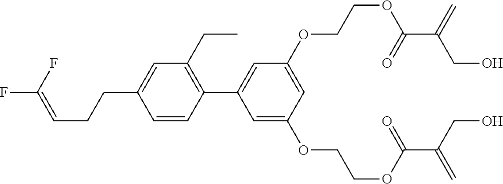 [SMILES: C=C(CO)C(=O)OCCOc1cc(OCCOC(=O)C(=C)CO)cc(-c2ccc(CCC=C(F)F)cc2CC)c1] |
| 1γ-1-74 | 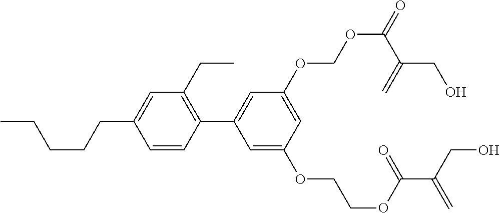 [SMILES: C=C(CO)C(=O)OCCOc1cc(OCOC(=O)C(=C)CO)cc(-c2ccc(CCCCC)cc2CC)c1] |
| 1γ-1-75 | 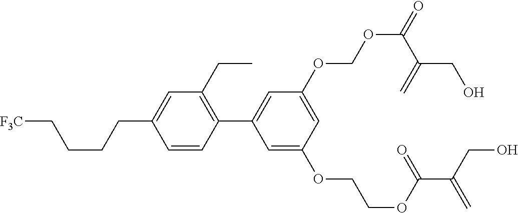 [SMILES: C=C(CO)C(=O)OCCOc1cc(OCOC(=O)C(=C)CO)cc(-c2ccc(CCCCC(F)(F)F)cc2CC)c1] |
| 1γ-1-76 | 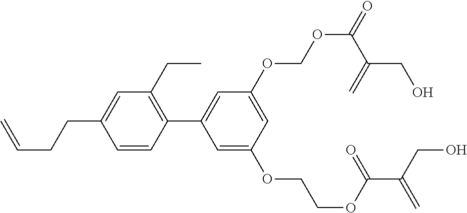 [SMILES: C=CCCc1ccc(-c2cc(OCCOC(=O)C(=C)CO)cc(OCOC(=O)C(=C)CO)c2)c(CC)c1] |
| 1γ-1-77 | 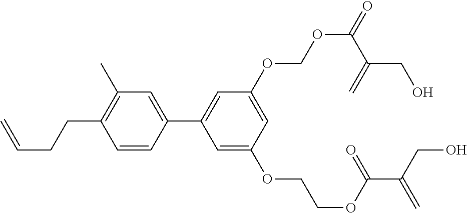 [SMILES: C=CCCc1ccc(-c2cc(OCCOC(=O)C(=C)CO)cc(OCOC(=O)C(=C)CO)c2)cc1C] |
| 1γ-1-78 | 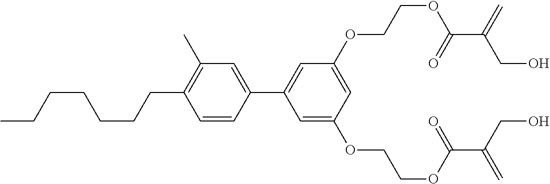 [SMILES: C=C(CO)C(=O)OCCOc1cc(OCCOC(=O)C(=C)CO)cc(-c2ccc(CCCCCCC)c(C)c2)c1] |
| 1γ-1-79 | 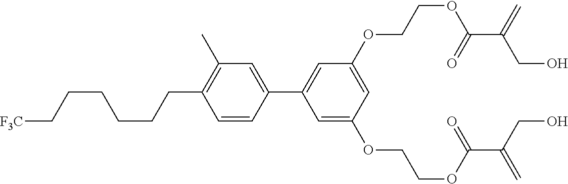 [SMILES: C=C(CO)C(=O)OCCOc1cc(OCCOC(=O)C(=C)CO)cc(-c2ccc(CCCCCCC(F)(F)F)c(C)c2)c1] |
| 1γ-1-80 | 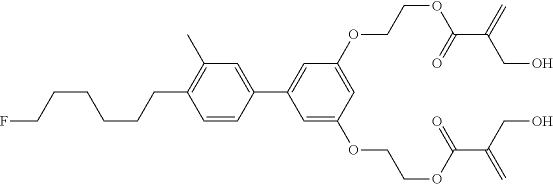 [SMILES: C=C(CO)C(=O)OCCOc1cc(OCCOC(=O)C(=C)CO)cc(-c2ccc(CCCCCCF)c(C)c2)c1] |
| 1γ-2-1 | 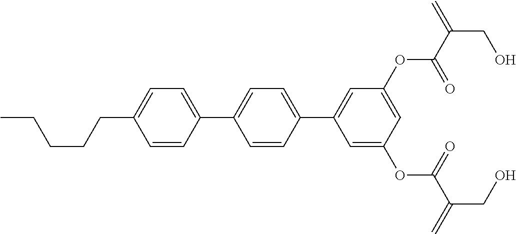 [SMILES: C=C(CO)C(=O)Oc1cc(OC(=O)C(=C)CO)cc(-c2ccc(-c3ccc(CCCCC)cc3)cc2)c1] |
| 1γ-2-2 | 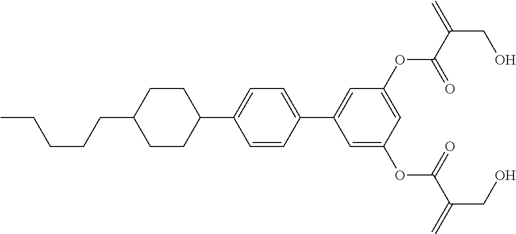 [SMILES: C=C(CO)C(=O)Oc1cc(OC(=O)C(=C)CO)cc(-c2ccc(C3CCC(CCCCC)CC3)cc2)c1] |
| 1γ-2-3 | 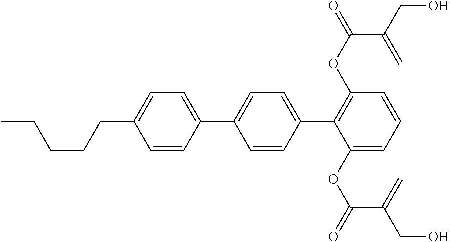 [SMILES: C=C(CO)C(=O)Oc1cccc(OC(=O)C(=C)CO)c1-c1ccc(-c2ccc(CCCCC)cc2)cc1] |
| 1γ-2-4 | 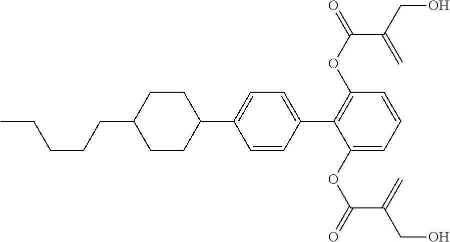 [SMILES: C=C(CO)C(=O)Oc1cccc(OC(=O)C(=C)CO)c1-c1ccc(C2CCC(CCCCC)CC2)cc1] |
| 1γ-2-5 | 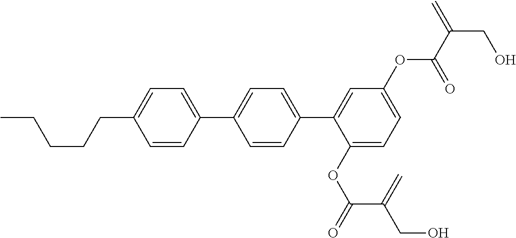 [SMILES: C=C(CO)C(=O)Oc1ccc(OC(=O)C(=C)CO)c(-c2ccc(-c3ccc(CCCCC)cc3)cc2)c1] |
| 1γ-2-6 | 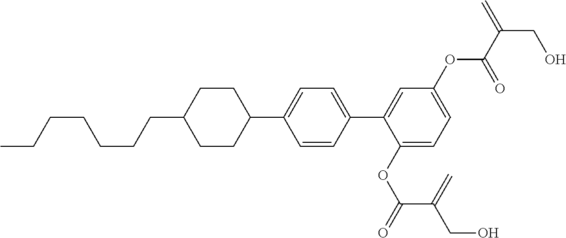 [SMILES: C=C(CO)C(=O)Oc1ccc(OC(=O)C(=C)CO)c(-c2ccc(C3CCC(CCCCCCC)CC3)cc2)c1] |
| 1γ-2-7 | 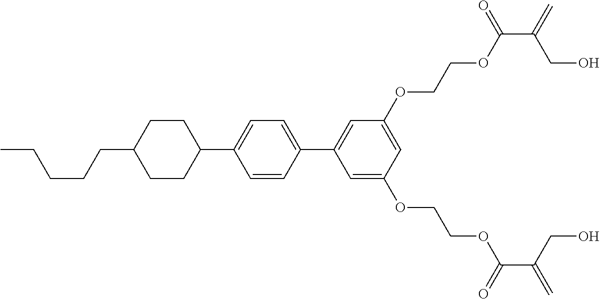 [SMILES: C=C(CO)C(=O)OCCOc1cc(OCCOC(=O)C(=C)CO)cc(-c2ccc(C3CCC(CCCCC)CC3)cc2)c1] |
| 1γ-2-8 | 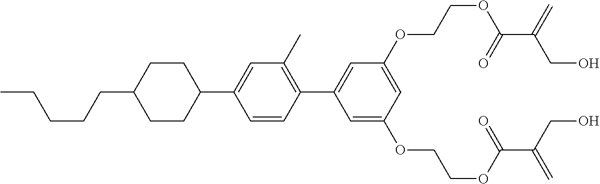 [SMILES: C=C(CO)C(=O)OCCOc1cc(OCCOC(=O)C(=C)CO)cc(-c2ccc(C3CCC(CCCCC)CC3)cc2C)c1] |
| 1γ-2-9 | 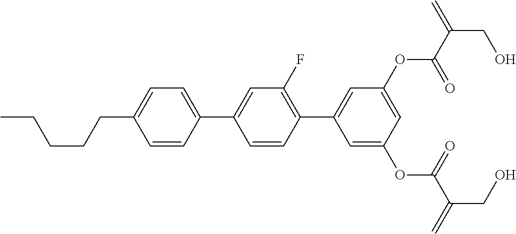 [SMILES: C=C(CO)C(=O)Oc1cc(OC(=O)C(=C)CO)cc(-c2ccc(-c3ccc(CCCCC)cc3)cc2F)c1] |
| 1γ-2-10 | 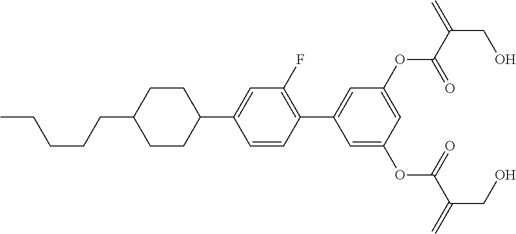 [SMILES: C=C(CO)C(=O)Oc1cc(OC(=O)C(=C)CO)cc(-c2ccc(C3CCC(CCCCC)CC3)cc2F)c1] |
| 1γ-2-11 | 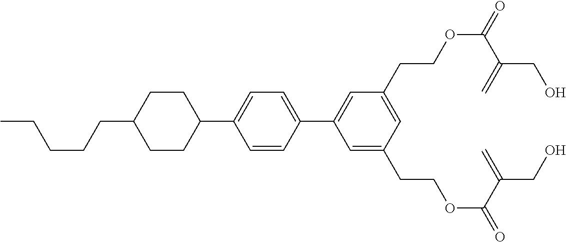 [SMILES: C=C(CO)C(=O)OCCc1cc(CCOC(=O)C(=C)CO)cc(-c2ccc(C3CCC(CCCCC)CC3)cc2)c1] |
| 1γ-2-12 | 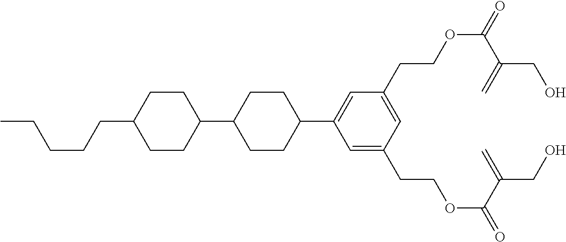 [SMILES: C=C(CO)C(=O)OCCc1cc(CCOC(=O)C(=C)CO)cc(C2CCC(C3CCC(CCCCC)CC3)CC2)c1] |
| 1γ-2-13 | 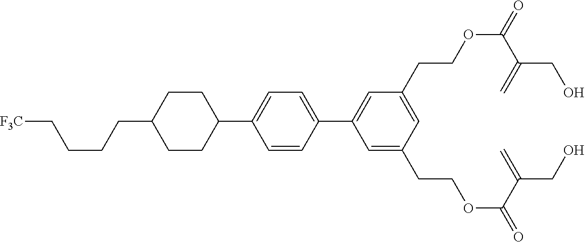 [SMILES: C=C(CO)C(=O)OCCc1cc(CCOC(=O)C(=C)CO)cc(-c2ccc(C3CCC(CCCCC(F)(F)F)CC3)cc2)c1] |
| 1γ-2-14 | 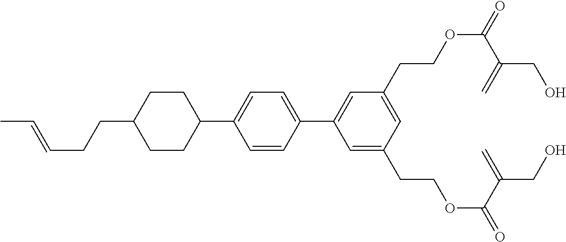 [SMILES: C=C(CO)C(=O)OCCc1cc(CCOC(=O)C(=C)CO)cc(-c2ccc(C3CCC(CC/C=C/C)CC3)cc2)c1] |
| 1γ-2-15 | 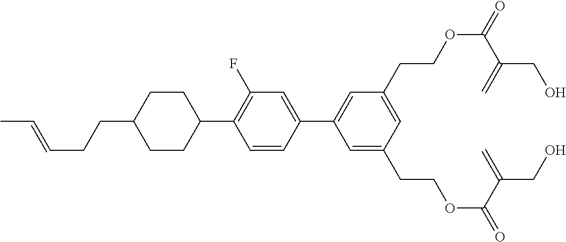 [SMILES: C=C(CO)C(=O)OCCc1cc(CCOC(=O)C(=C)CO)cc(-c2ccc(C3CCC(CC/C=C/C)CC3)c(F)c2)c1] |
| 1γ-2-16 | 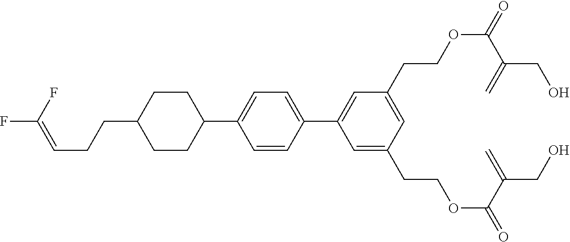 [SMILES: C=C(CO)C(=O)OCCc1cc(CCOC(=O)C(=C)CO)cc(-c2ccc(C3CCC(CCC=C(F)F)CC3)cc2)c1] |
| 1γ-2-17 | 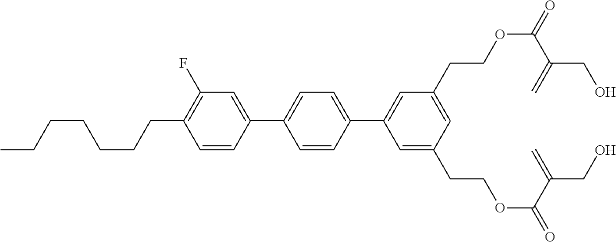 [SMILES: C=C(CO)C(=O)OCCc1cc(CCOC(=O)C(=C)CO)cc(-c2ccc(-c3ccc(CCCCCCC)c(F)c3)cc2)c1] |
| 1γ-2-18 | 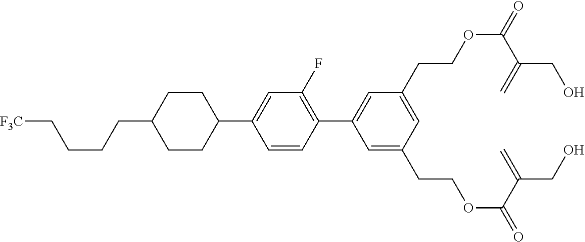 [SMILES: C=C(CO)C(=O)OCCc1cc(CCOC(=O)C(=C)CO)cc(-c2ccc(C3CCC(CCCCC(F)(F)F)CC3)cc2F)c1] |
| 1γ-2-19 | 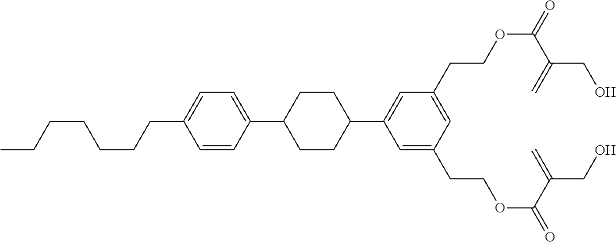 [SMILES: C=C(CO)C(=O)OCCc1cc(CCOC(=O)C(=C)CO)cc(C2CCC(c3ccc(CCCCCCC)cc3)CC2)c1] |
| 1γ-2-20 | 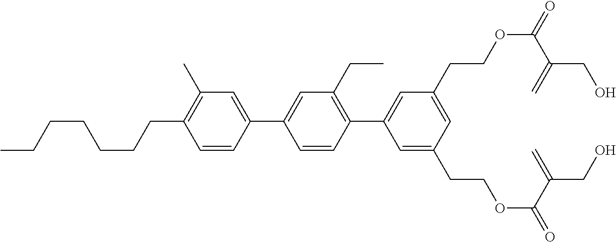 [SMILES: C=C(CO)C(=O)OCCc1cc(CCOC(=O)C(=C)CO)cc(-c2ccc(-c3ccc(CCCCCCC)c(C)c3)cc2CC)c1] |
| 1γ-2-21 | 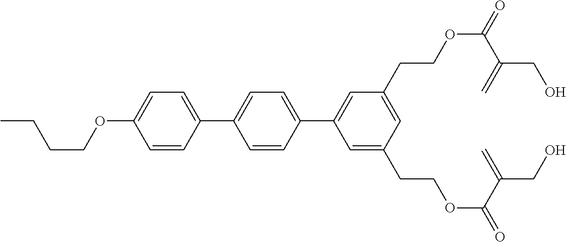 [SMILES: C=C(CO)C(=O)OCCc1cc(CCOC(=O)C(=C)CO)cc(-c2ccc(-c3ccc(OCCCC)cc3)cc2)c1] |
| 1γ-2-22 | 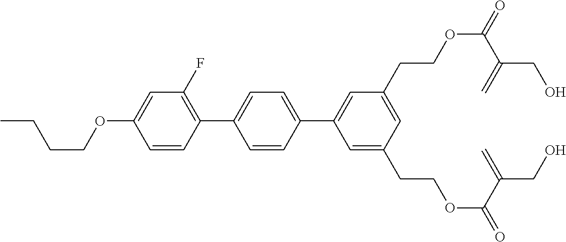 [SMILES: C=C(CO)C(=O)OCCc1cc(CCOC(=O)C(=C)CO)cc(-c2ccc(-c3ccc(OCCCC)cc3F)cc2)c1] |
| 1γ-2-23 | 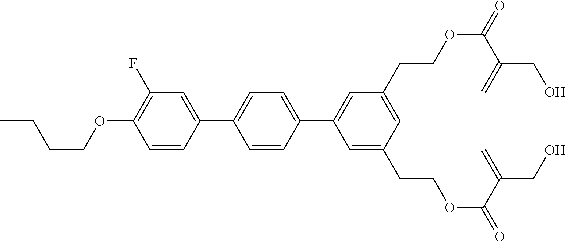 [SMILES: C=C(CO)C(=O)OCCc1cc(CCOC(=O)C(=C)CO)cc(-c2ccc(-c3ccc(OCCCC)c(F)c3)cc2)c1] |
| 1γ-2-24 | 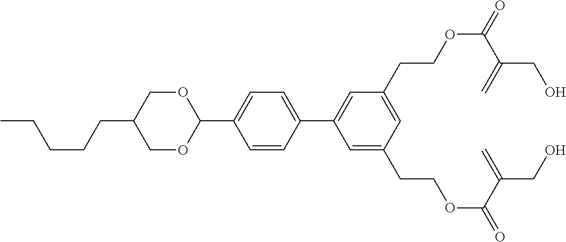 [SMILES: C=C(CO)C(=O)OCCc1cc(CCOC(=O)C(=C)CO)cc(-c2ccc(C3OCC(CCCCC)CO3)cc2)c1] |
| 1γ-2-25 | 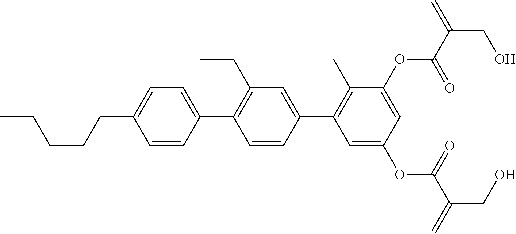 [SMILES: C=C(CO)C(=O)Oc1cc(OC(=O)C(=C)CO)c(C)c(-c2ccc(-c3ccc(CCCCC)cc3)c(CC)c2)c1] |
| 1γ-2-26 | 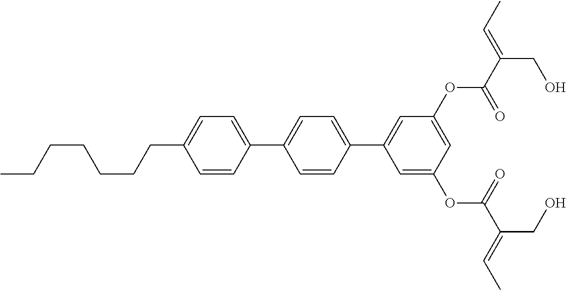 [SMILES: C/C=C(\CO)C(=O)Oc1cc(OC(=O)/C(=C/C)CO)cc(-c2ccc(-c3ccc(CCCCCCC)cc3)cc2)c1] |
| 1γ-2-27 | 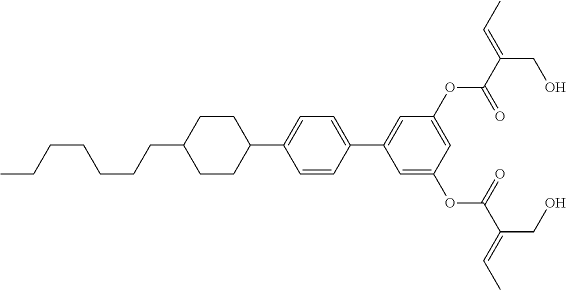 [SMILES: C/C=C(\CO)C(=O)Oc1cc(OC(=O)/C(=C/C)CO)cc(-c2ccc(C3CCC(CCCCCCC)CC3)cc2)c1] |
| 1γ-2-28 | 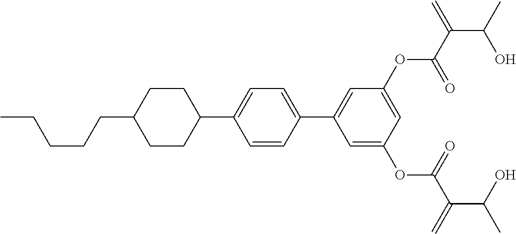 [SMILES: C=C(C(=O)Oc1cc(OC(=O)C(=C)C(C)O)cc(-c2ccc(C3CCC(CCCCC)CC3)cc2)c1)C(C)O] |
| 1γ-2-29 | 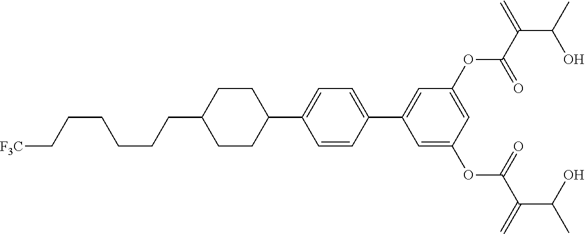 [SMILES: C=C(C(=O)Oc1cc(OC(=O)C(=C)C(C)O)cc(-c2ccc(C3CCC(CCCCCCC(F)(F)F)CC3)cc2)c1)C(C)O] |
| 1γ-2-30 | 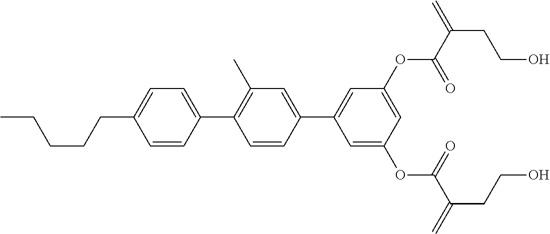 [SMILES: C=C(CCO)C(=O)Oc1cc(OC(=O)C(=C)CCO)cc(-c2ccc(-c3ccc(CCCCC)cc3)c(C)c2)c1] |
| 1γ-2-31 | 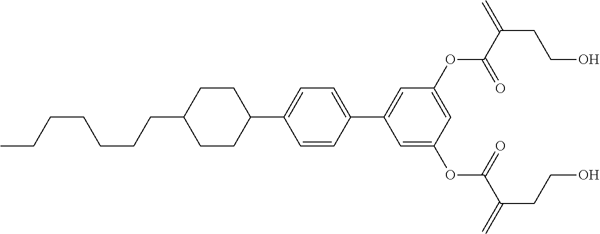 [SMILES: C=C(CCO)C(=O)Oc1cc(OC(=O)C(=C)CCO)cc(-c2ccc(C3CCC(CCCCCCC)CC3)cc2)c1] |
| 1γ-2-32 | 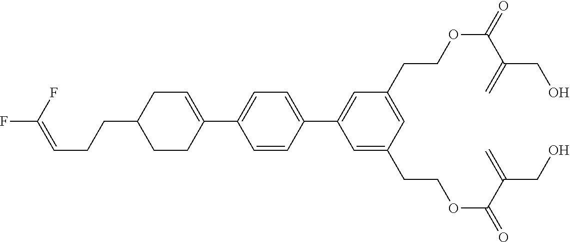 [SMILES: C=C(CO)C(=O)OCCc1cc(CCOC(=O)C(=C)CO)cc(-c2ccc(C3=CCC(CCC=C(F)F)CC3)cc2)c1] |
| 1γ-2-33 | 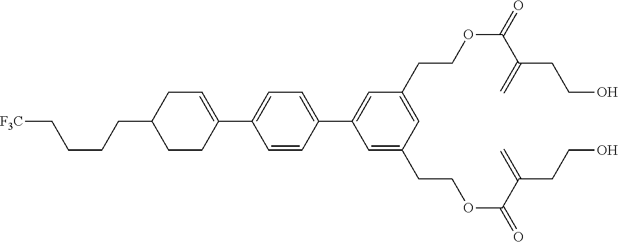 [SMILES: C=C(CCO)C(=O)OCCc1cc(CCOC(=O)C(=C)CCO)cc(-c2ccc(C3=CCC(CCCCC(F)(F)F)CC3)cc2)c1] |
| 1γ-2-34 | 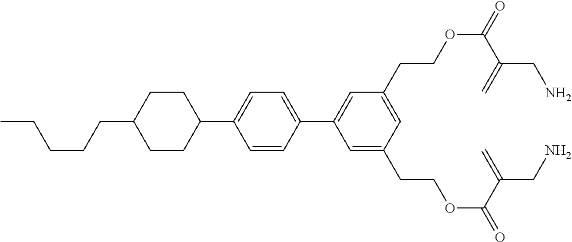 [SMILES: C=C(CN)C(=O)OCCc1cc(CCOC(=O)C(=C)CN)cc(-c2ccc(C3CCC(CCCCC)CC3)cc2)c1] |
| 1γ-2-35 | 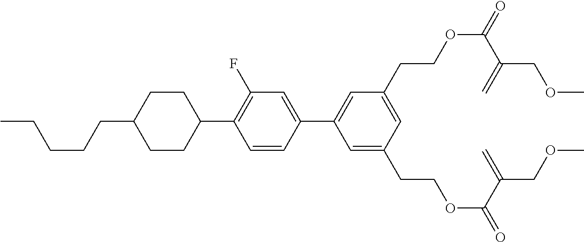 [SMILES: C=C(COC)C(=O)OCCc1cc(CCOC(=O)C(=C)COC)cc(-c2ccc(C3CCC(CCCCC)CC3)c(F)c2)c1] |
| 1γ-2-36 | 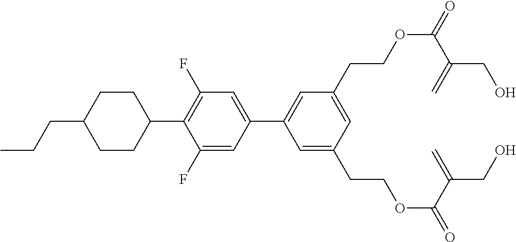 [SMILES: C=C(CO)C(=O)OCCc1cc(CCOC(=O)C(=C)CO)cc(-c2cc(F)c(C3CCC(CCC)CC3)c(F)c2)c1] |
| 1γ-2-37 | 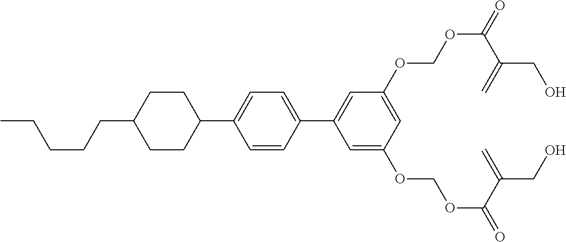 [SMILES: C=C(CO)C(=O)OCOc1cc(OCOC(=O)C(=C)CO)cc(-c2ccc(C3CCC(CCCCC)CC3)cc2)c1] |
| 1γ-2-38 | 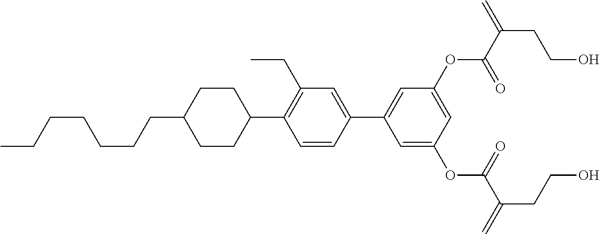 [SMILES: C=C(CCO)C(=O)Oc1cc(OC(=O)C(=C)CCO)cc(-c2ccc(C3CCC(CCCCCCC)CC3)c(CC)c2)c1] |
| 1γ-2-39 | 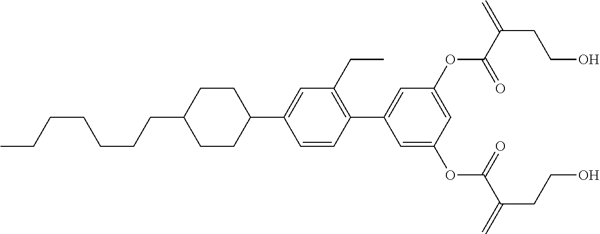 [SMILES: C=C(CCO)C(=O)Oc1cc(OC(=O)C(=C)CCO)cc(-c2ccc(C3CCC(CCCCCCC)CC3)cc2CC)c1] |
| 1γ-2-40 | 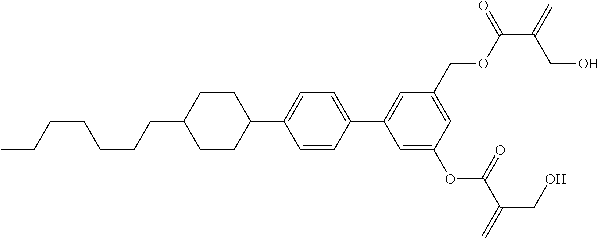 [SMILES: C=C(CO)C(=O)OCc1cc(OC(=O)C(=C)CO)cc(-c2ccc(C3CCC(CCCCCCC)CC3)cc2)c1] |
| 1γ-2-41 | 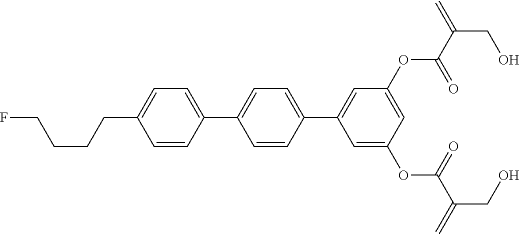 [SMILES: C=C(CO)C(=O)Oc1cc(OC(=O)C(=C)CO)cc(-c2ccc(-c3ccc(CCCCF)cc3)cc2)c1] |
| 1γ-2-42 | 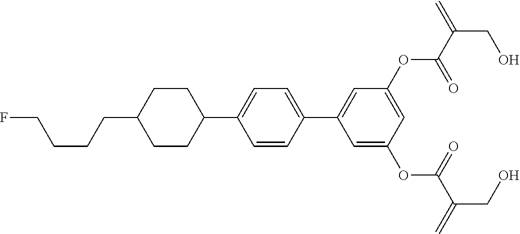 [SMILES: C=C(CO)C(=O)Oc1cc(OC(=O)C(=C)CO)cc(-c2ccc(C3CCC(CCCCF)CC3)cc2)c1] |
| 1γ-2-43 | 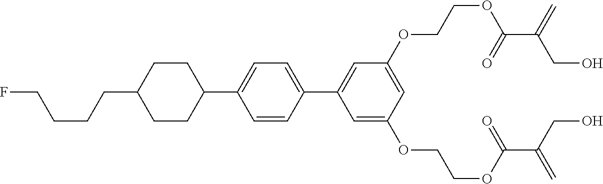 [SMILES: C=C(CO)C(=O)OCCOc1cc(OCCOC(=O)C(=C)CO)cc(-c2ccc(C3CCC(CCCCF)CC3)cc2)c1] |
| 1γ-2-44 | 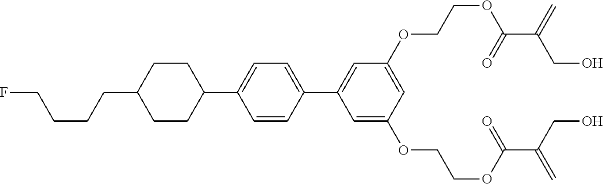 [SMILES: C=C(CO)C(=O)OCCOc1cc(OCCOC(=O)C(=C)CO)cc(-c2ccc(C3CCC(CCCCF)CC3)cc2)c1] |
| 1γ-2-45 | 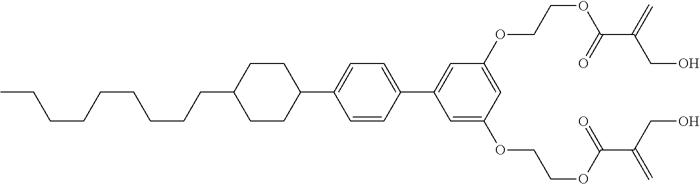 [SMILES: C=C(CO)C(=O)OCCOc1cc(OCCOC(=O)C(=C)CO)cc(-c2ccc(C3CCC(CCCCCCCCC)CC3)cc2)c1] |
| 1γ-2-46 | 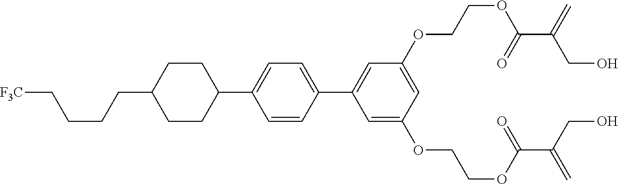 [SMILES: C=C(CO)C(=O)OCCOc1cc(OCCOC(=O)C(=C)CO)cc(-c2ccc(C3CCC(CCCCC(F)(F)F)CC3)cc2)c1] |
| 1γ-2-47 | 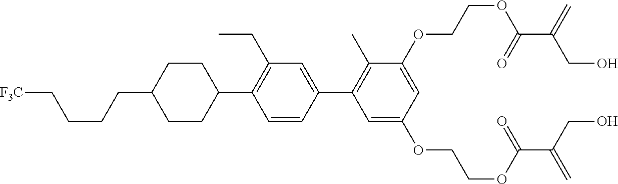 [SMILES: C=C(CO)C(=O)OCCOc1cc(OCCOC(=O)C(=C)CO)c(C)c(-c2ccc(C3CCC(CCCCC(F)(F)F)CC3)c(CC)c2)c1] |
| 1γ-2-48 | 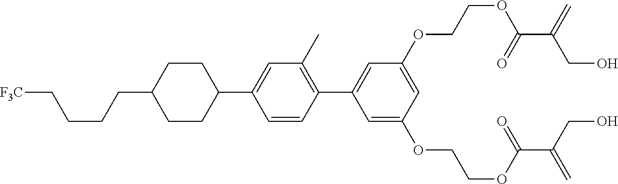 [SMILES: C=C(CO)C(=O)OCCOc1cc(OCCOC(=O)C(=C)CO)cc(-c2ccc(C3CCC(CCCCC(F)(F)F)CC3)cc2C)c1] |
| 1γ-2-49 | 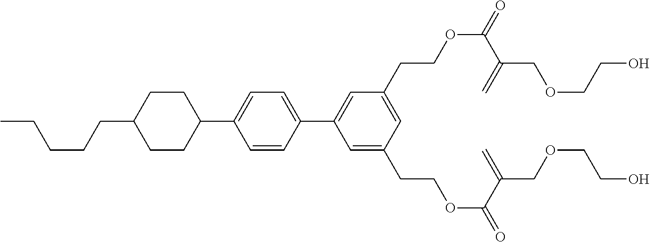 [SMILES: C=C(COCCO)C(=O)OCCc1cc(CCOC(=O)C(=C)COCCO)cc(-c2ccc(C3CCC(CCCCC)CC3)cc2)c1] |
| 1γ-2-50 | 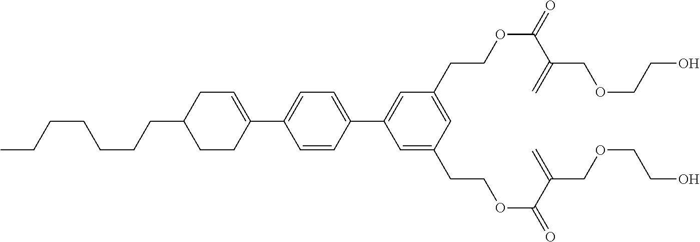 [SMILES: C=C(COCCO)C(=O)OCCc1cc(CCOC(=O)C(=C)COCCO)cc(-c2ccc(C3=CCC(CCCCCCC)CC3)cc2)c1] |
| 1γ-2-51 | 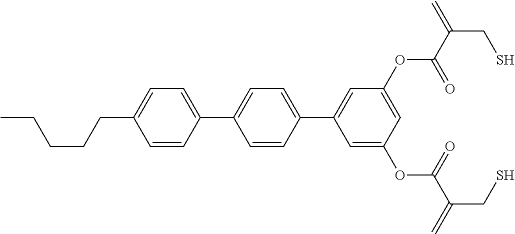 [SMILES: C=C(CS)C(=O)Oc1cc(OC(=O)C(=C)CS)cc(-c2ccc(-c3ccc(CCCCC)cc3)cc2)c1] |
| 1γ-2-52 | 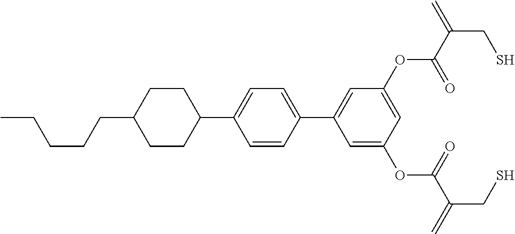 [SMILES: C=C(CS)C(=O)Oc1cc(OC(=O)C(=C)CS)cc(-c2ccc(C3CCC(CCCCC)CC3)cc2)c1] |
| 1γ-2-53 | 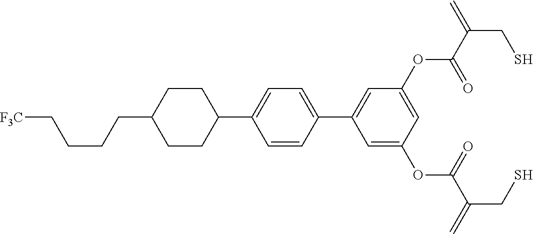 [SMILES: C=C(CS)C(=O)Oc1cc(OC(=O)C(=C)CS)cc(-c2ccc(C3CCC(CCCCC(F)(F)F)CC3)cc2)c1] |
| 1γ-2-54 | 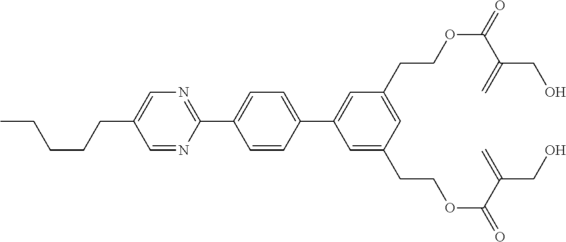 [SMILES: C=C(CO)C(=O)OCCc1cc(CCOC(=O)C(=C)CO)cc(-c2ccc(-c3ncc(CCCCC)cn3)cc2)c1] |
| 1γ-2-55 | 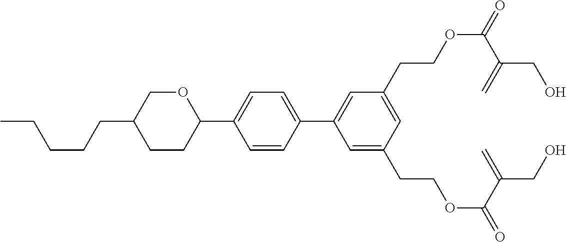 [SMILES: C=C(CO)C(=O)OCCc1cc(CCOC(=O)C(=C)CO)cc(-c2ccc(C3CCC(CCCCC)CO3)cc2)c1] |
| 1γ-2-56 | 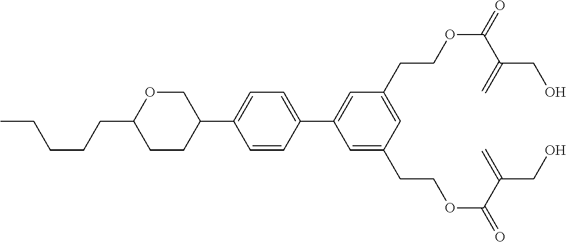 [SMILES: C=C(CO)C(=O)OCCc1cc(CCOC(=O)C(=C)CO)cc(-c2ccc(C3CCC(CCCCC)OC3)cc2)c1] |
| 1γ-2-57 | 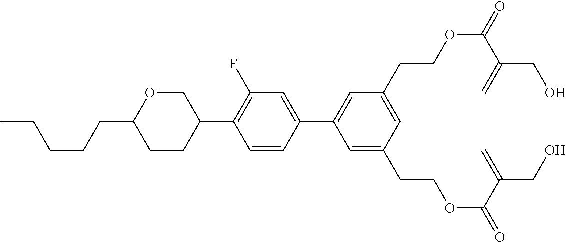 [SMILES: C=C(CO)C(=O)OCCc1cc(CCOC(=O)C(=C)CO)cc(-c2ccc(C3CCC(CCCCC)OC3)c(F)c2)c1] |
| 1γ-2-58 | 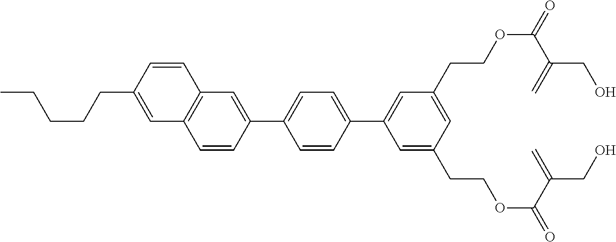 [SMILES: C=C(CO)C(=O)OCCc1cc(CCOC(=O)C(=C)CO)cc(-c2ccc(-c3ccc4cc(CCCCC)ccc4c3)cc2)c1] |
| 1γ-2-59 | 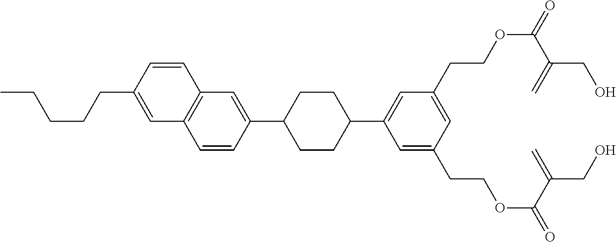 [SMILES: C=C(CO)C(=O)OCCc1cc(CCOC(=O)C(=C)CO)cc(C2CCC(c3ccc4cc(CCCCC)ccc4c3)CC2)c1] |
| 1γ-2-60 | 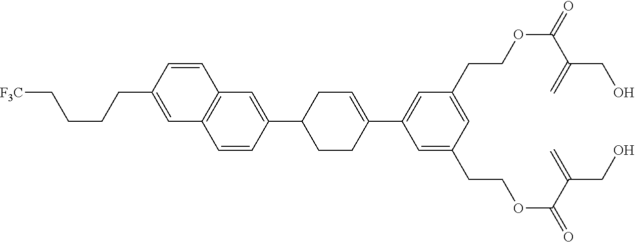 [SMILES: C=C(CO)C(=O)OCCc1cc(CCOC(=O)C(=C)CO)cc(C2=CCC(c3ccc4cc(CCCCC(F)(F)F)ccc4c3)CC2)c1] |
| 1γ-2-61 | 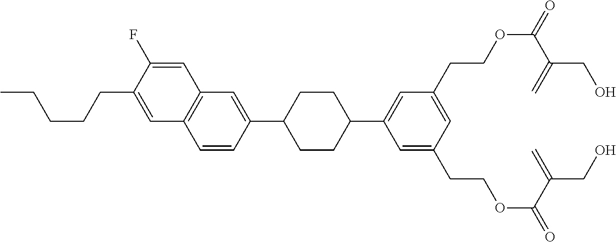 [SMILES: C=C(CO)C(=O)OCCc1cc(CCOC(=O)C(=C)CO)cc(C2CCC(c3ccc4cc(CCCCC)c(F)cc4c3)CC2)c1] |
| 1γ-2-62 | 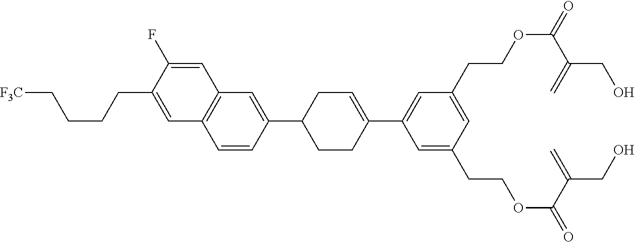 [SMILES: C=C(CO)C(=O)OCCc1cc(CCOC(=O)C(=C)CO)cc(C2=CCC(c3ccc4cc(CCCCC(F)(F)F)c(F)cc4c3)CC2)c1] |
| 1γ-2-63 | 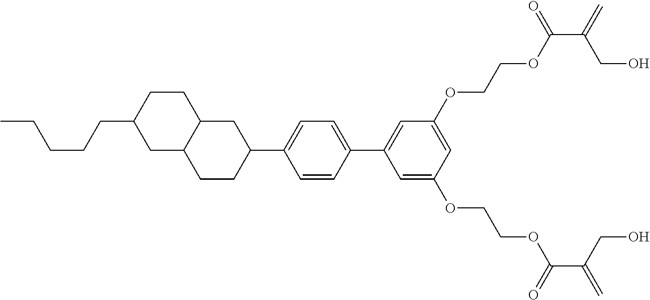 [SMILES: C=C(CO)C(=O)OCCOc1cc(OCCOC(=O)C(=C)CO)cc(-c2ccc(C3CCC4CC(CCCCC)CCC4C3)cc2)c1] |
| 1γ-2-64 | 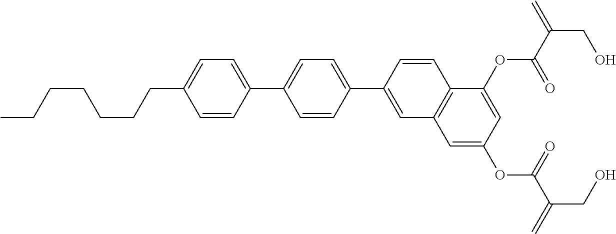 [SMILES: C=C(CO)C(=O)Oc1cc(OC(=O)C(=C)CO)c2ccc(-c3ccc(-c4ccc(CCCCCCC)cc4)cc3)cc2c1] |
| 1γ-2-65 | 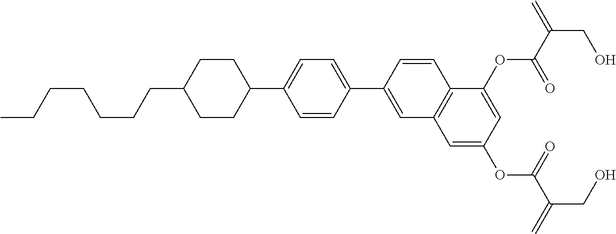 [SMILES: C=C(CO)C(=O)Oc1cc(OC(=O)C(=C)CO)c2ccc(-c3ccc(C4CCC(CCCCCCC)CC4)cc3)cc2c1] |
| 1γ-2-66 | 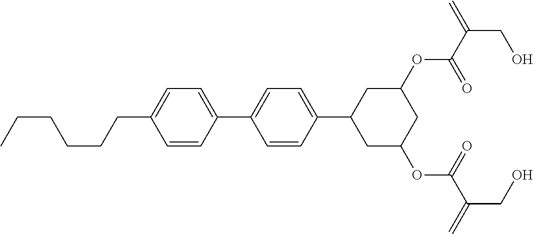 [SMILES: C=C(CO)C(=O)OC1CC(OC(=O)C(=C)CO)CC(c2ccc(-c3ccc(CCCCCC)cc3)cc2)C1] |
| 1γ-2-67 | 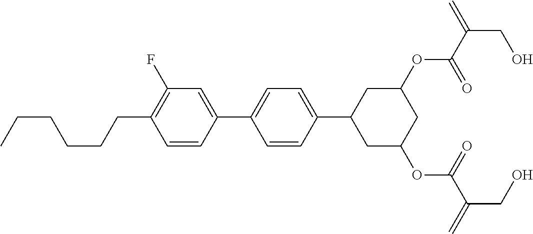 [SMILES: C=C(CO)C(=O)OC1CC(OC(=O)C(=C)CO)CC(c2ccc(-c3ccc(CCCCCC)c(F)c3)cc2)C1] |
| 1γ-2-68 | 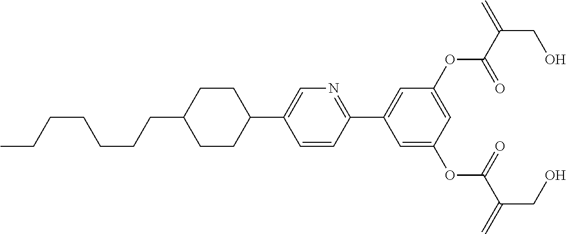 [SMILES: C=C(CO)C(=O)Oc1cc(OC(=O)C(=C)CO)cc(-c2ccc(C3CCC(CCCCCCC)CC3)cn2)c1] |
| 1γ-2-69 | 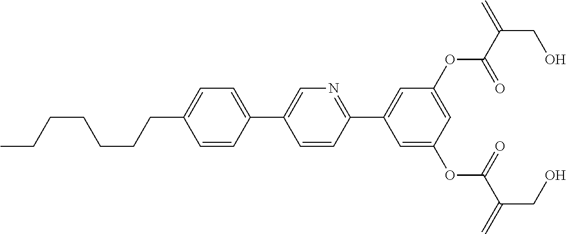 [SMILES: C=C(CO)C(=O)Oc1cc(OC(=O)C(=C)CO)cc(-c2ccc(-c3ccc(CCCCCCC)cc3)cn2)c1] |
| 1γ-2-70 | 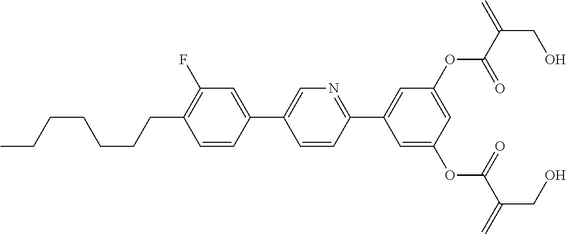 [SMILES: C=C(CO)C(=O)Oc1cc(OC(=O)C(=C)CO)cc(-c2ccc(-c3ccc(CCCCCCC)c(F)c3)cn2)c1] |
| 1γ-2-71 | 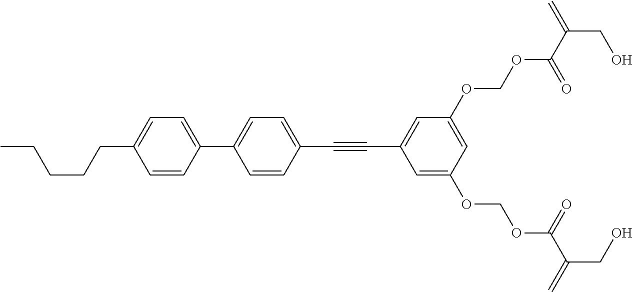 [SMILES: C=C(CO)C(=O)OCOc1cc(C#Cc2ccc(-c3ccc(CCCCC)cc3)cc2)cc(OCOC(=O)C(=C)CO)c1] |
| 1γ-2-72 | 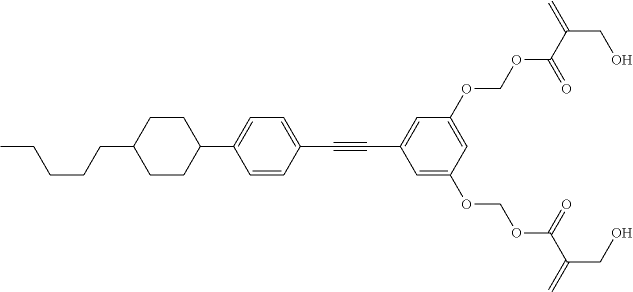 [SMILES: C=C(CO)C(=O)OCOc1cc(C#Cc2ccc(C3CCC(CCCCC)CC3)cc2)cc(OCOC(=O)C(=C)CO)c1] |
| 1γ-2-73 | 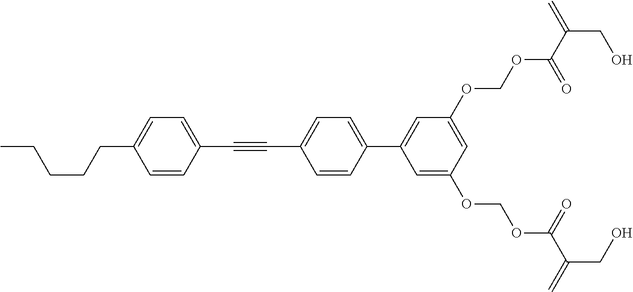 [SMILES: C=C(CO)C(=O)OCOc1cc(OCOC(=O)C(=C)CO)cc(-c2ccc(C#Cc3ccc(CCCCC)cc3)cc2)c1] |
| 1γ-2-74 | 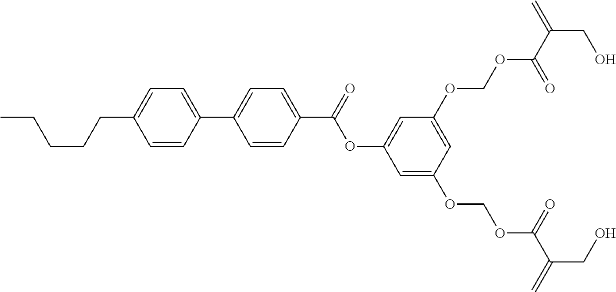 [SMILES: C=C(CO)C(=O)OCOc1cc(OCOC(=O)C(=C)CO)cc(OC(=O)c2ccc(-c3ccc(CCCCC)cc3)cc2)c1] |
| 1γ-2-75 | 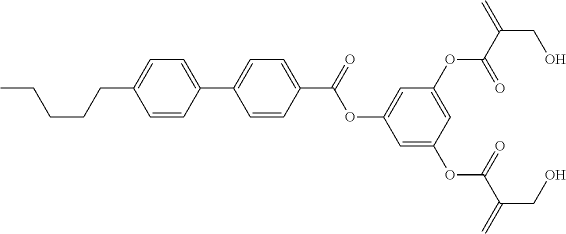 [SMILES: C=C(CO)C(=O)Oc1cc(OC(=O)C(=C)CO)cc(OC(=O)c2ccc(-c3ccc(CCCCC)cc3)cc2)c1] |
| 1γ-2-76 | 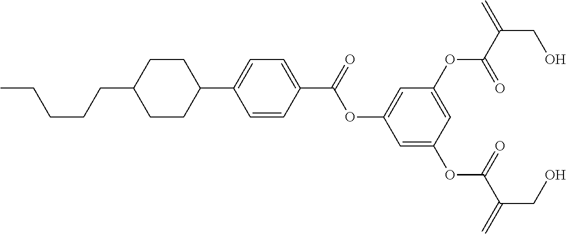 [SMILES: C=C(CO)C(=O)Oc1cc(OC(=O)C(=C)CO)cc(OC(=O)c2ccc(C3CCC(CCCCC)CC3)cc2)c1] |
| 1γ-2-77 | 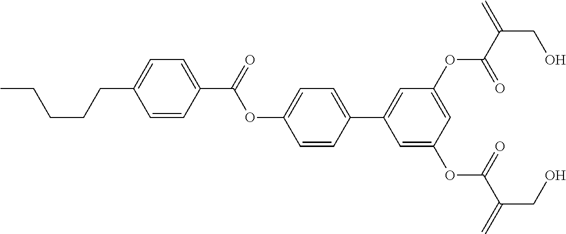 [SMILES: C=C(CO)C(=O)Oc1cc(OC(=O)C(=C)CO)cc(-c2ccc(OC(=O)c3ccc(CCCCC)cc3)cc2)c1] |
| 1γ-2-78 | 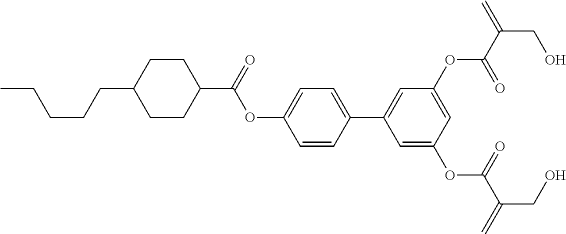 [SMILES: C=C(CO)C(=O)Oc1cc(OC(=O)C(=C)CO)cc(-c2ccc(OC(=O)C3CCC(CCCCC)CC3)cc2)c1] |
| 1γ-2-79 | 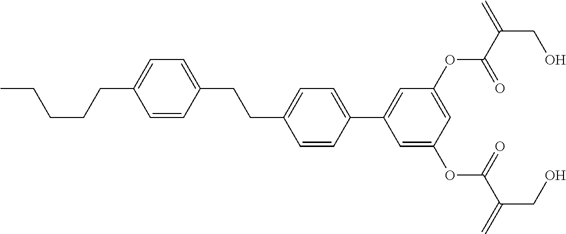 [SMILES: C=C(CO)C(=O)Oc1cc(OC(=O)C(=C)CO)cc(-c2ccc(CCc3ccc(CCCCC)cc3)cc2)c1] |
| 1γ-2-80 | 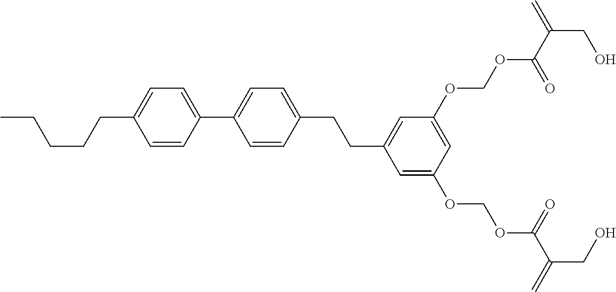 [SMILES: C=C(CO)C(=O)OCOc1cc(CCc2ccc(-c3ccc(CCCCC)cc3)cc2)cc(OCOC(=O)C(=C)CO)c1] |
| 1γ-2-81 | 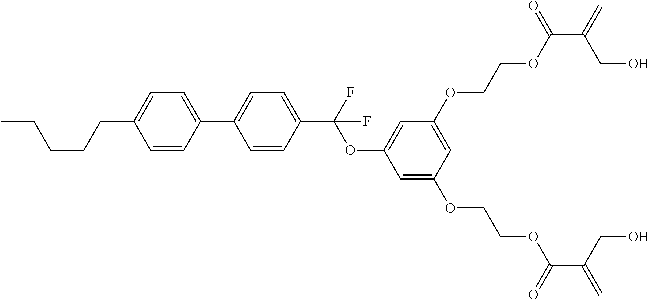 [SMILES: C=C(CO)C(=O)OCCOc1cc(OCCOC(=O)C(=C)CO)cc(OC(F)(F)c2ccc(-c3ccc(CCCCC)cc3)cc2)c1] |
| 1γ-2-82 | 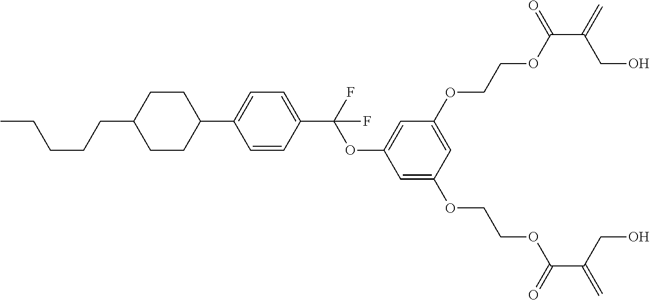 [SMILES: C=C(CO)C(=O)OCCOc1cc(OCCOC(=O)C(=C)CO)cc(OC(F)(F)c2ccc(C3CCC(CCCCC)CC3)cc2)c1] |
| 1γ-2-83 | 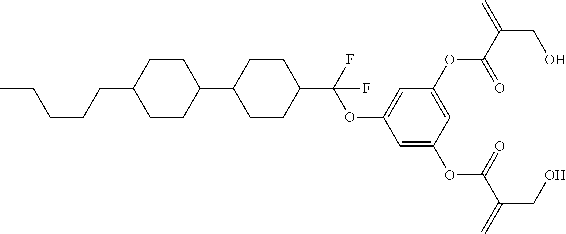 [SMILES: C=C(CO)C(=O)Oc1cc(OC(=O)C(=C)CO)cc(OC(F)(F)C2CCC(C3CCC(CCCCC)CC3)CC2)c1] |
| 1γ-2-84 | 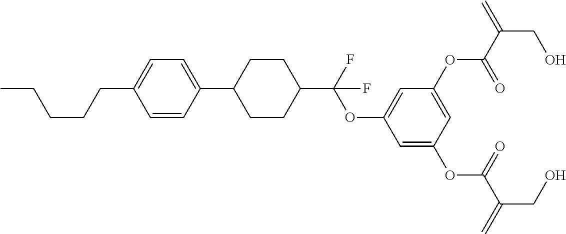 [SMILES: C=C(CO)C(=O)Oc1cc(OC(=O)C(=C)CO)cc(OC(F)(F)C2CCC(c3ccc(CCCCC)cc3)CC2)c1] |
| 1γ-2-85 | 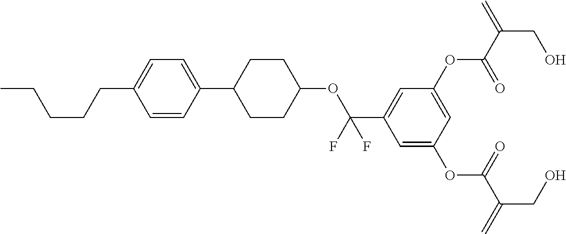 [SMILES: C=C(CO)C(=O)Oc1cc(OC(=O)C(=C)CO)cc(C(F)(F)OC2CCC(c3ccc(CCCCC)cc3)CC2)c1] |
| 1γ-2-86 | 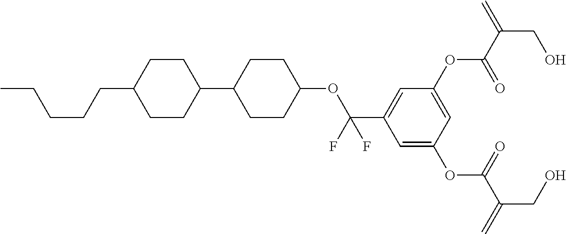 [SMILES: C=C(CO)C(=O)Oc1cc(OC(=O)C(=C)CO)cc(C(F)(F)OC2CCC(C3CCC(CCCCC)CC3)CC2)c1] |
| 1γ-2-87 | 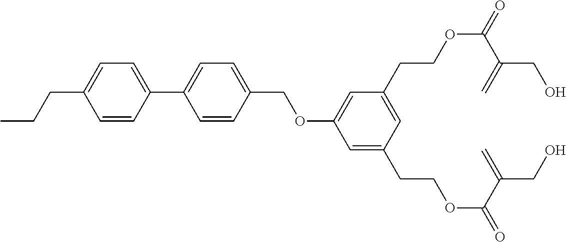 [SMILES: C=C(CO)C(=O)OCCc1cc(CCOC(=O)C(=C)CO)cc(OCc2ccc(-c3ccc(CCC)cc3)cc2)c1] |
| 1γ-2-88 | 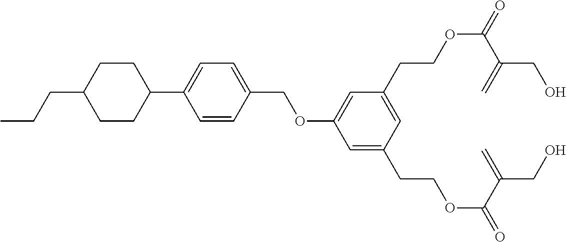 [SMILES: C=C(CO)C(=O)OCCc1cc(CCOC(=O)C(=C)CO)cc(OCc2ccc(C3CCC(CCC)CC3)cc2)c1] |
| 1γ-2-89 | 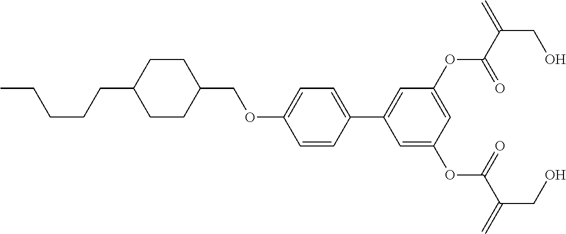 [SMILES: C=C(CO)C(=O)Oc1cc(OC(=O)C(=C)CO)cc(-c2ccc(OCC3CCC(CCCCC)CC3)cc2)c1] |
| 1γ-2-90 | 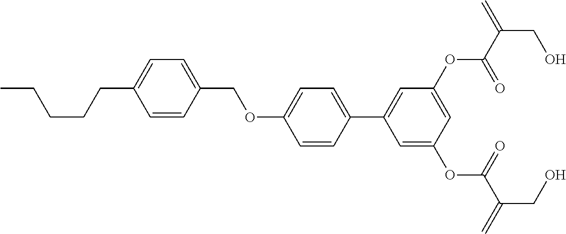 [SMILES: C=C(CO)C(=O)Oc1cc(OC(=O)C(=C)CO)cc(-c2ccc(OCc3ccc(CCCCC)cc3)cc2)c1] |
| 1γ-2-91 | 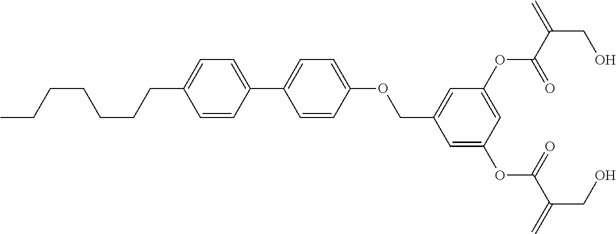 [SMILES: C=C(CO)C(=O)Oc1cc(COc2ccc(-c3ccc(CCCCCCC)cc3)cc2)cc(OC(=O)C(=C)CO)c1] |
| 1γ-2-92 | 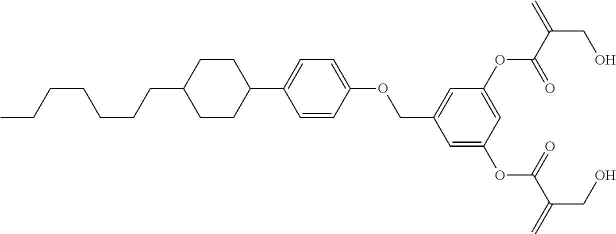 [SMILES: C=C(CO)C(=O)Oc1cc(COc2ccc(C3CCC(CCCCCCC)CC3)cc2)cc(OC(=O)C(=C)CO)c1] |
| 1γ-2-93 | 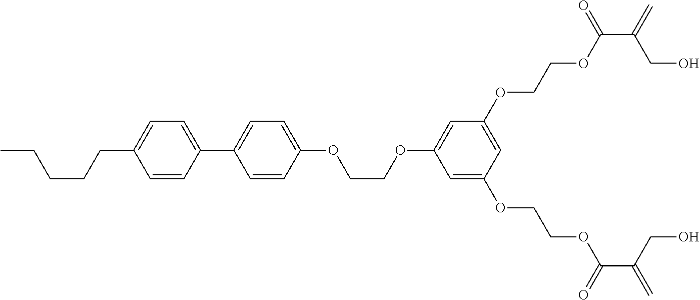 [SMILES: C=C(CO)C(=O)OCCOc1cc(OCCOC(=O)C(=C)CO)cc(OCCOc2ccc(-c3ccc(CCCCC)cc3)cc2)c1] |
| 1γ-2-94 | 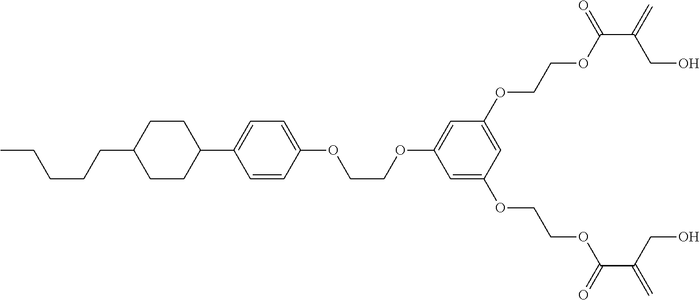 [SMILES: C=C(CO)C(=O)OCCOc1cc(OCCOC(=O)C(=C)CO)cc(OCCOc2ccc(C3CCC(CCCCC)CC3)cc2)c1] |
| 1γ-2-95 | 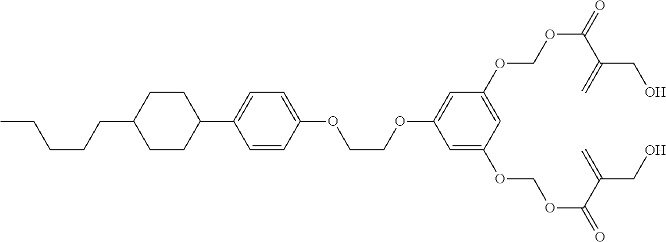 [SMILES: C=C(CO)C(=O)OCOc1cc(OCCOc2ccc(C3CCC(CCCCC)CC3)cc2)cc(OCOC(=O)C(=C)CO)c1] |
| 1γ-2-96 | 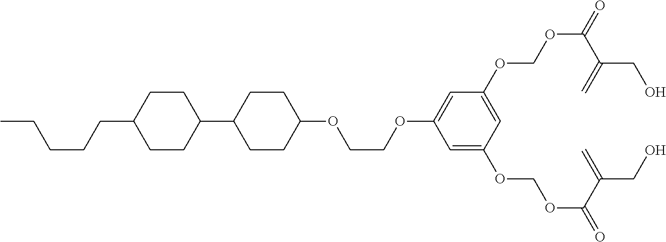 [SMILES: C=C(CO)C(=O)OCOc1cc(OCCOC2CCC(C3CCC(CCCCC)CC3)CC2)cc(OCOC(=O)C(=C)CO)c1] |
| 1γ-2-97 | 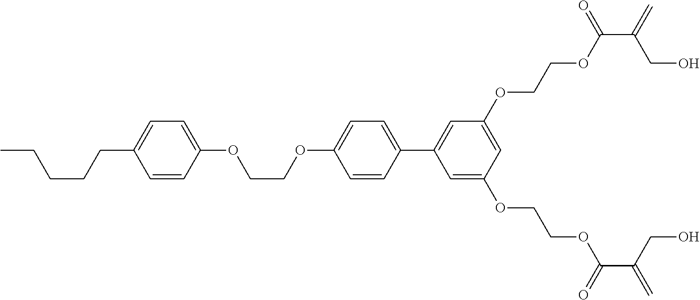 [SMILES: C=C(CO)C(=O)OCCOc1cc(OCCOC(=O)C(=C)CO)cc(-c2ccc(OCCOc3ccc(CCCCC)cc3)cc2)c1] |
| 1γ-2-98 | 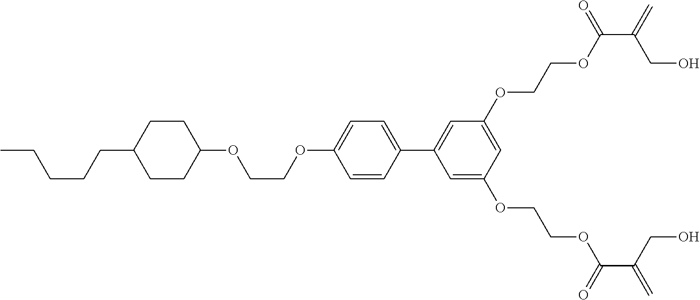 [SMILES: C=C(CO)C(=O)OCCOc1cc(OCCOC(=O)C(=C)CO)cc(-c2ccc(OCCOC3CCC(CCCCC)CC3)cc2)c1] |
| 1γ-2-99 | 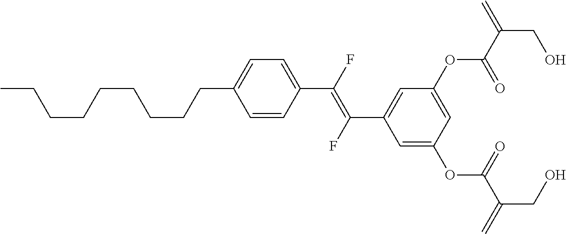 [SMILES: C=C(CO)C(=O)Oc1cc(OC(=O)C(=C)CO)cc(/C(F)=C(\F)c2ccc(CCCCCCCCC)cc2)c1] |
| 1γ-2-100 | 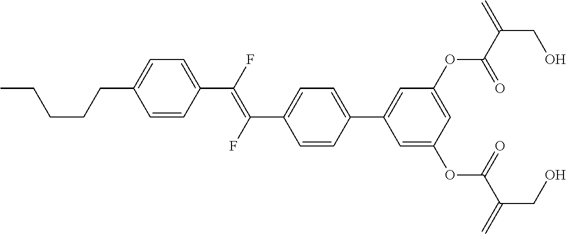 [SMILES: C=C(CO)C(=O)Oc1cc(OC(=O)C(=C)CO)cc(-c2ccc(/C(F)=C(\F)c3ccc(CCCCC)cc3)cc2)c1] |
| 1γ-2-101 | 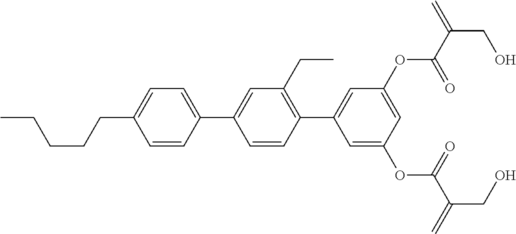 [SMILES: C=C(CO)C(=O)Oc1cc(OC(=O)C(=C)CO)cc(-c2ccc(-c3ccc(CCCCC)cc3)cc2CC)c1] |
| 1γ-2-102 | 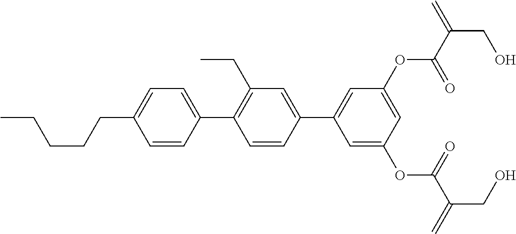 [SMILES: C=C(CO)C(=O)Oc1cc(OC(=O)C(=C)CO)cc(-c2ccc(-c3ccc(CCCCC)cc3)c(CC)c2)c1] |
| 1γ-2-103 | 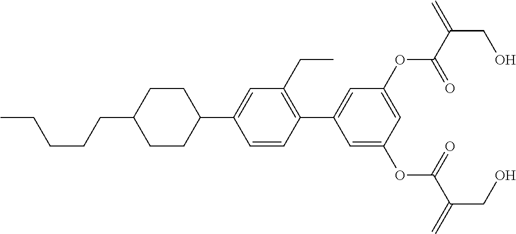 [SMILES: C=C(CO)C(=O)Oc1cc(OC(=O)C(=C)CO)cc(-c2ccc(C3CCC(CCCCC)CC3)cc2CC)c1] |
| 1γ-2-104 | 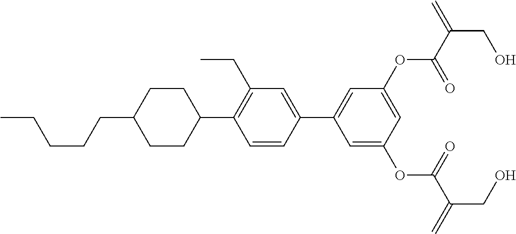 [SMILES: C=C(CO)C(=O)Oc1cc(OC(=O)C(=C)CO)cc(-c2ccc(C3CCC(CCCCC)CC3)c(CC)c2)c1] |
| 1γ-2-105 | 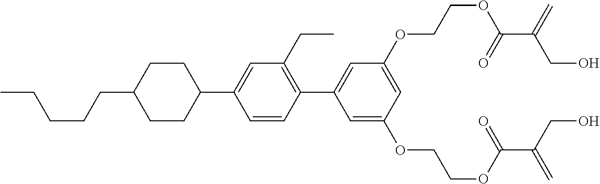 [SMILES: C=C(CO)C(=O)OCCOc1cc(OCCOC(=O)C(=C)CO)cc(-c2ccc(C3CCC(CCCCC)CC3)cc2CC)c1] |
| 1γ-2-106 | 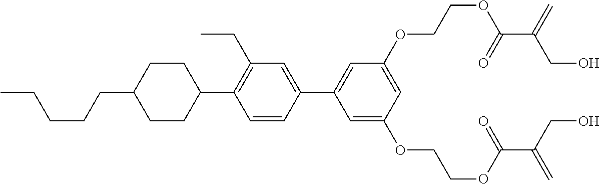 [SMILES: C=C(CO)C(=O)OCCOc1cc(OCCOC(=O)C(=C)CO)cc(-c2ccc(C3CCC(CCCCC)CC3)c(CC)c2)c1] |
| 1γ-2-107 | 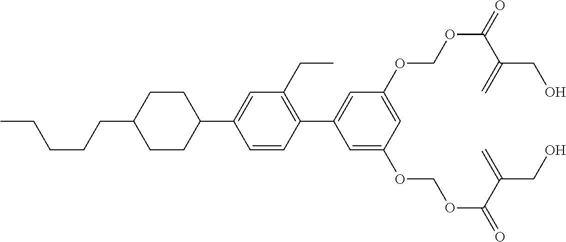 [SMILES: C=C(CO)C(=O)OCOc1cc(OCOC(=O)C(=C)CO)cc(-c2ccc(C3CCC(CCCCC)CC3)cc2CC)c1] |
| 1γ-2-108 | 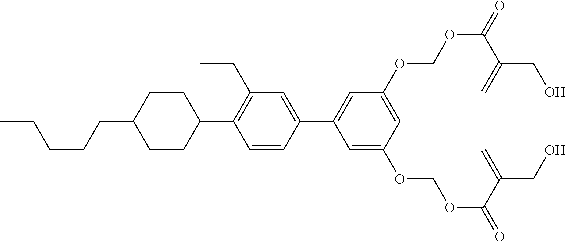 [SMILES: C=C(CO)C(=O)OCOc1cc(OCOC(=O)C(=C)CO)cc(-c2ccc(C3CCC(CCCCC)CC3)c(CC)c2)c1] |
| 1γ-2-109 | 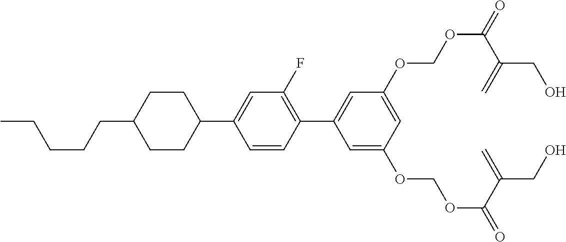 [SMILES: C=C(CO)C(=O)OCOc1cc(OCOC(=O)C(=C)CO)cc(-c2ccc(C3CCC(CCCCC)CC3)cc2F)c1] |
| 1γ-2-110 | 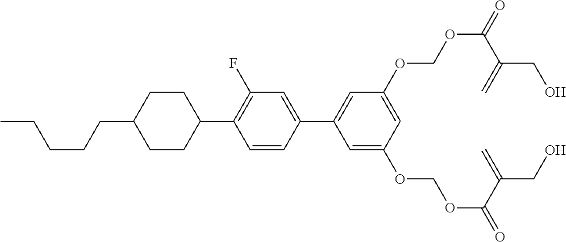 [SMILES: C=C(CO)C(=O)OCOc1cc(OCOC(=O)C(=C)CO)cc(-c2ccc(C3CCC(CCCCC)CC3)c(F)c2)c1] |
| 1γ-2-111 | 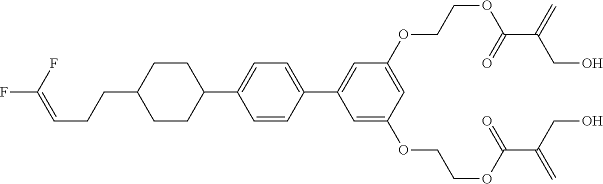 [SMILES: C=C(CO)C(=O)OCCOc1cc(OCCOC(=O)C(=C)CO)cc(-c2ccc(C3CCC(CCC=C(F)F)CC3)cc2)c1] |
| 1γ-2-112 | 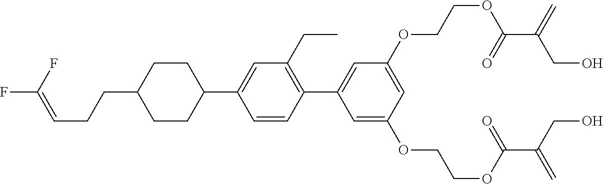 [SMILES: C=C(CO)C(=O)OCCOc1cc(OCCOC(=O)C(=C)CO)cc(-c2ccc(C3CCC(CCC=C(F)F)CC3)cc2CC)c1] |
| 1γ-2-113 | 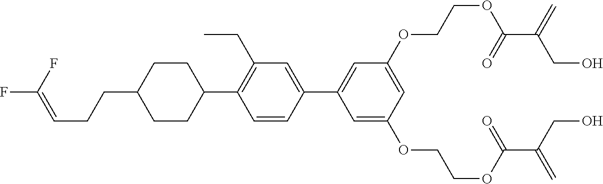 [SMILES: C=C(CO)C(=O)OCCOc1cc(OCCOC(=O)C(=C)CO)cc(-c2ccc(C3CCC(CCC=C(F)F)CC3)c(CC)c2)c1] |
| 1γ-2-114 | 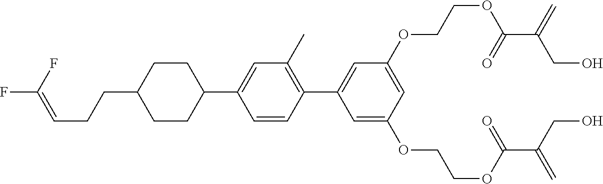 [SMILES: C=C(CO)C(=O)OCCOc1cc(OCCOC(=O)C(=C)CO)cc(-c2ccc(C3CCC(CCC=C(F)F)CC3)cc2C)c1] |
| 1γ-2-115 | 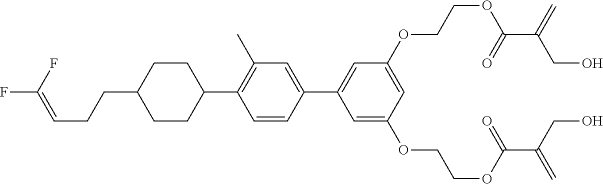 [SMILES: C=C(CO)C(=O)OCCOc1cc(OCCOC(=O)C(=C)CO)cc(-c2ccc(C3CCC(CCC=C(F)F)CC3)c(C)c2)c1] |
| 1γ-2-116 | 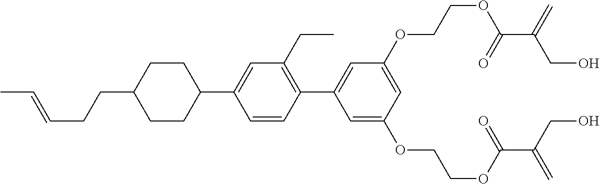 [SMILES: C=C(CO)C(=O)OCCOc1cc(OCCOC(=O)C(=C)CO)cc(-c2ccc(C3CCC(CC/C=C/C)CC3)cc2CC)c1] |
| 1γ-2-117 | 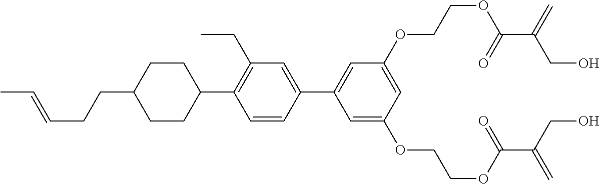 [SMILES: C=C(CO)C(=O)OCCOc1cc(OCCOC(=O)C(=C)CO)cc(-c2ccc(C3CCC(CC/C=C/C)CC3)c(CC)c2)c1] |
| 1γ-2-118 | 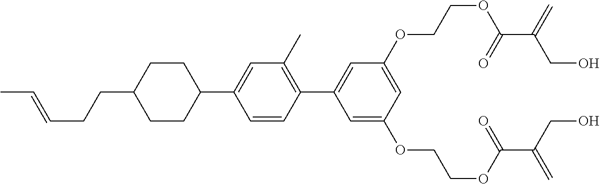 [SMILES: C=C(CO)C(=O)OCCOc1cc(OCCOC(=O)C(=C)CO)cc(-c2ccc(C3CCC(CC/C=C/C)CC3)cc2C)c1] |
| 1γ-2-119 | 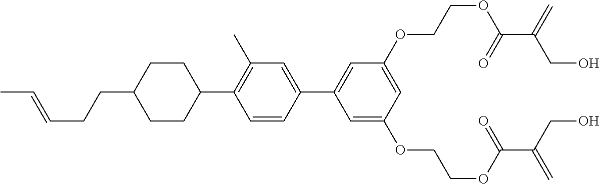 [SMILES: C=C(CO)C(=O)OCCOc1cc(OCCOC(=O)C(=C)CO)cc(-c2ccc(C3CCC(CC/C=C/C)CC3)c(C)c2)c1] |
| 1γ-2-120 | 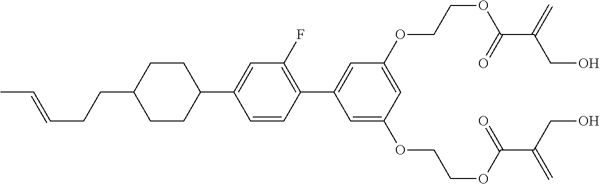 [SMILES: C=C(CO)C(=O)OCCOc1cc(OCCOC(=O)C(=C)CO)cc(-c2ccc(C3CCC(CC/C=C/C)CC3)cc2F)c1] |
| 1γ-2-121 | 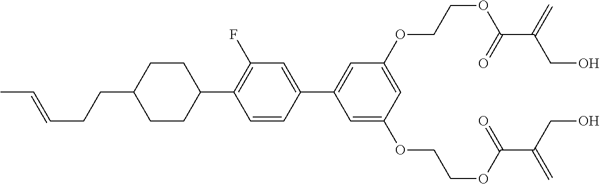 [SMILES: C=C(CO)C(=O)OCCOc1cc(OCCOC(=O)C(=C)CO)cc(-c2ccc(C3CCC(CC/C=C/C)CC3)c(F)c2)c1] |
| 1γ-2-122 | 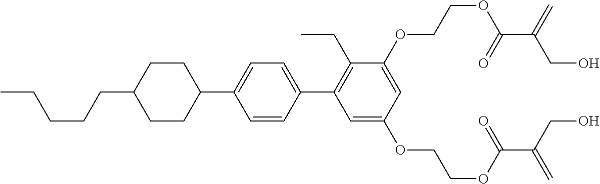 [SMILES: C=C(CO)C(=O)OCCOc1cc(OCCOC(=O)C(=C)CO)c(CC)c(-c2ccc(C3CCC(CCCCC)CC3)cc2)c1] |
| 1γ-2-123 | 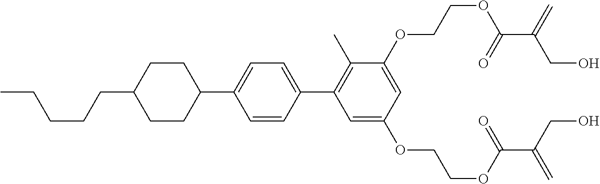 [SMILES: C=C(CO)C(=O)OCCOc1cc(OCCOC(=O)C(=C)CO)c(C)c(-c2ccc(C3CCC(CCCCC)CC3)cc2)c1] |
| 1γ-2-124 | 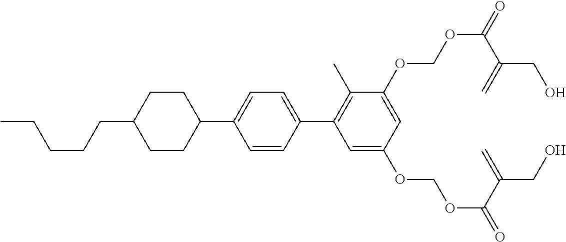 [SMILES: C=C(CO)C(=O)OCOc1cc(OCOC(=O)C(=C)CO)c(C)c(-c2ccc(C3CCC(CCCCC)CC3)cc2)c1] |
| 1γ-2-125 | 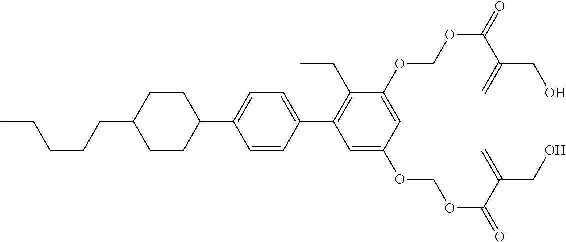 [SMILES: C=C(CO)C(=O)OCOc1cc(OCOC(=O)C(=C)CO)c(CC)c(-c2ccc(C3CCC(CCCCC)CC3)cc2)c1] |
| 1γ-2-126 | 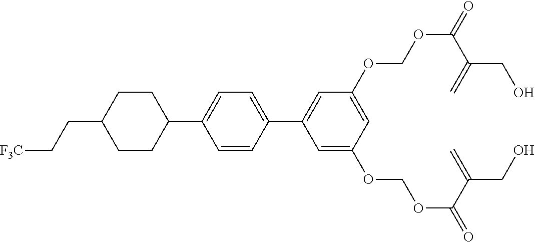 [SMILES: C=C(CO)C(=O)OCOc1cc(OCOC(=O)C(=C)CO)cc(-c2ccc(C3CCC(CCC(F)(F)F)CC3)cc2)c1] |
| 1γ-2-127 | 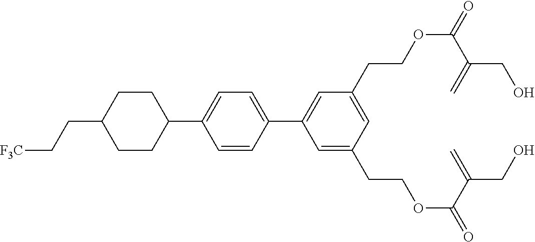 [SMILES: C=C(CO)C(=O)OCCc1cc(CCOC(=O)C(=C)CO)cc(-c2ccc(C3CCC(CCC(F)(F)F)CC3)cc2)c1] |
| 1γ-2-128 | 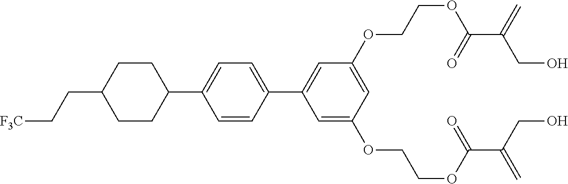 [SMILES: C=C(CO)C(=O)OCCOc1cc(OCCOC(=O)C(=C)CO)cc(-c2ccc(C3CCC(CCC(F)(F)F)CC3)cc2)c1] |
| 1γ-2-129 | 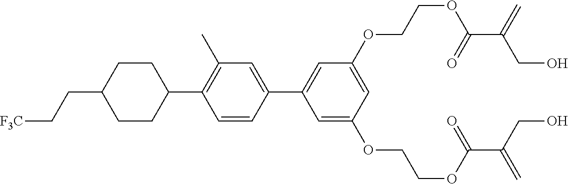 [SMILES: C=C(CO)C(=O)OCCOc1cc(OCCOC(=O)C(=C)CO)cc(-c2ccc(C3CCC(CCC(F)(F)F)CC3)c(C)c2)c1] |
| 1γ-2-130 | 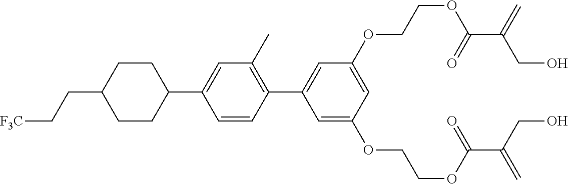 [SMILES: C=C(CO)C(=O)OCCOc1cc(OCCOC(=O)C(=C)CO)cc(-c2ccc(C3CCC(CCC(F)(F)F)CC3)cc2C)c1] |
| 1γ-2-131 | 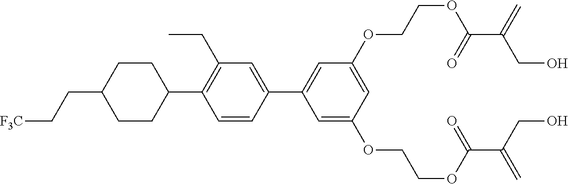 [SMILES: C=C(CO)C(=O)OCCOc1cc(OCCOC(=O)C(=C)CO)cc(-c2ccc(C3CCC(CCC(F)(F)F)CC3)c(CC)c2)c1] |
| 1γ-2-132 | 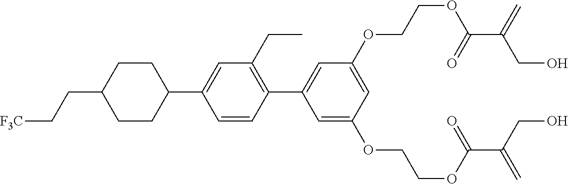 [SMILES: C=C(CO)C(=O)OCCOc1cc(OCCOC(=O)C(=C)CO)cc(-c2ccc(C3CCC(CCC(F)(F)F)CC3)cc2CC)c1] |
| 1γ-2-133 | 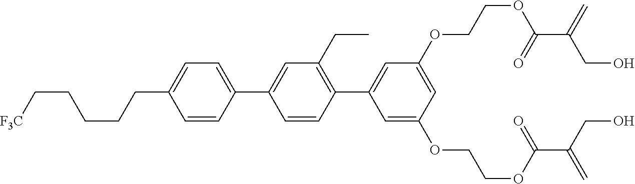 [SMILES: C=C(CO)C(=O)OCCOc1cc(OCCOC(=O)C(=C)CO)cc(-c2ccc(-c3ccc(CCCCCC(F)(F)F)cc3)cc2CC)c1] |
| 1γ-2-134 | 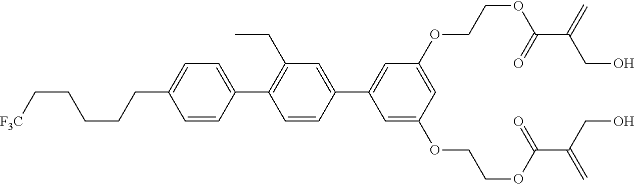 [SMILES: C=C(CO)C(=O)OCCOc1cc(OCCOC(=O)C(=C)CO)cc(-c2ccc(-c3ccc(CCCCCC(F)(F)F)cc3)c(CC)c2)c1] |
| 1γ-2-135 | 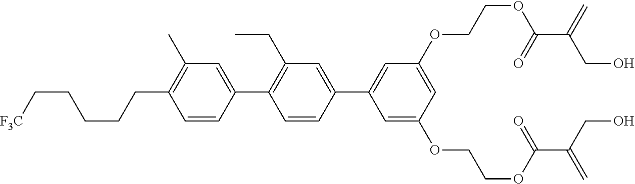 [SMILES: C=C(CO)C(=O)OCCOc1cc(OCCOC(=O)C(=C)CO)cc(-c2ccc(-c3ccc(CCCCCC(F)(F)F)c(C)c3)c(CC)c2)c1] |
| 1γ-2-136 | 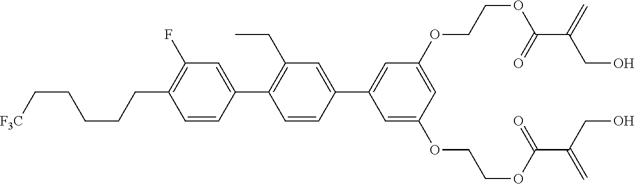 [SMILES: C=C(CO)C(=O)OCCOc1cc(OCCOC(=O)C(=C)CO)cc(-c2ccc(-c3ccc(CCCCCC(F)(F)F)c(F)c3)c(CC)c2)c1] |
| 1γ-2-137 | 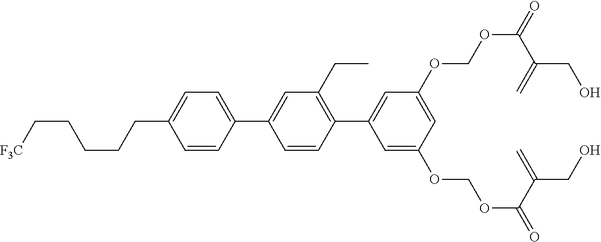 [SMILES: C=C(CO)C(=O)OCOc1cc(OCOC(=O)C(=C)CO)cc(-c2ccc(-c3ccc(CCCCCC(F)(F)F)cc3)cc2CC)c1] |
| 1γ-2-138 | 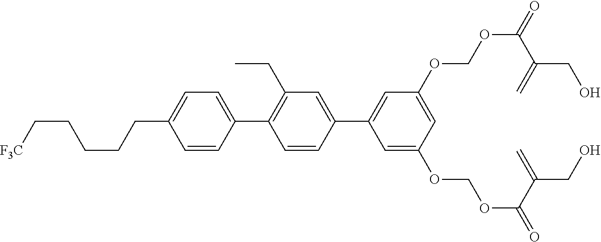 [SMILES: C=C(CO)C(=O)OCOc1cc(OCOC(=O)C(=C)CO)cc(-c2ccc(-c3ccc(CCCCCC(F)(F)F)cc3)c(CC)c2)c1] |
| 1γ-2-139 | 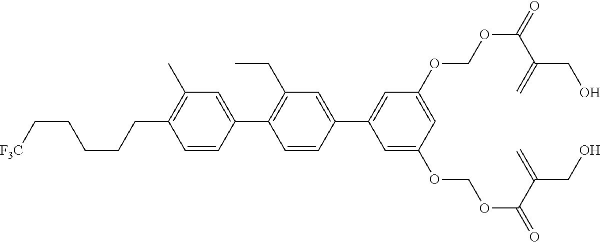 [SMILES: C=C(CO)C(=O)OCOc1cc(OCOC(=O)C(=C)CO)cc(-c2ccc(-c3ccc(CCCCCC(F)(F)F)c(C)c3)c(CC)c2)c1] |
| 1γ-2-140 | 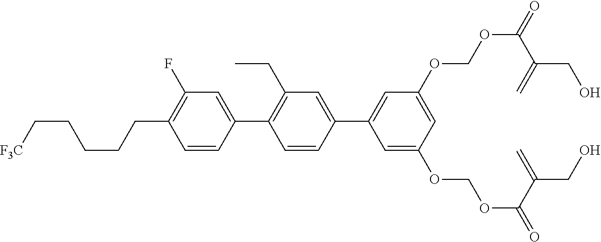 [SMILES: C=C(CO)C(=O)OCOc1cc(OCOC(=O)C(=C)CO)cc(-c2ccc(-c3ccc(CCCCCC(F)(F)F)c(F)c3)c(CC)c2)c1] |
| 1γ-2-141 | 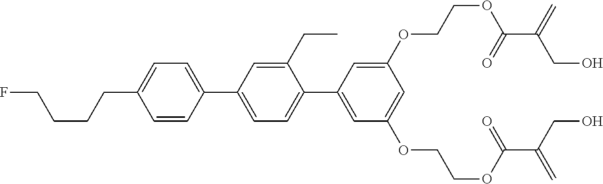 [SMILES: C=C(CO)C(=O)OCCOc1cc(OCCOC(=O)C(=C)CO)cc(-c2ccc(-c3ccc(CCCCF)cc3)cc2CC)c1] |
| 1γ-2-142 | 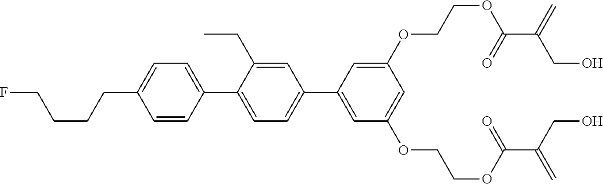 [SMILES: C=C(CO)C(=O)OCCOc1cc(OCCOC(=O)C(=C)CO)cc(-c2ccc(-c3ccc(CCCCF)cc3)c(CC)c2)c1] |
| 1γ-2-143 | 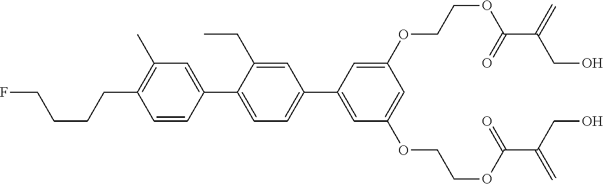 [SMILES: C=C(CO)C(=O)OCCOc1cc(OCCOC(=O)C(=C)CO)cc(-c2ccc(-c3ccc(CCCCF)c(C)c3)c(CC)c2)c1] |
| 1γ-2-144 | 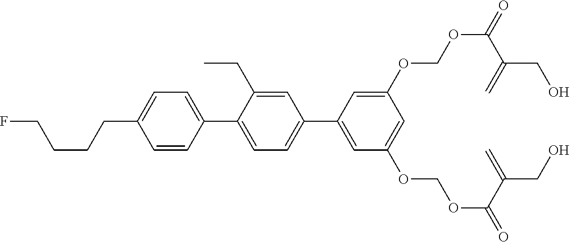 [SMILES: C=C(CO)C(=O)OCOc1cc(OCOC(=O)C(=C)CO)cc(-c2ccc(-c3ccc(CCCCF)cc3)c(CC)c2)c1] |
| 1γ-2-145 | 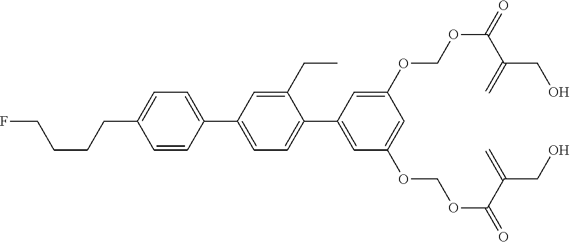 [SMILES: C=C(CO)C(=O)OCOc1cc(OCOC(=O)C(=C)CO)cc(-c2ccc(-c3ccc(CCCCF)cc3)cc2CC)c1] |
| 1γ-2-146 | 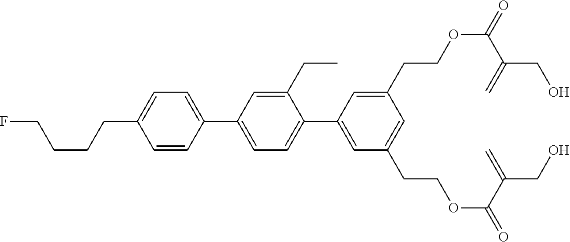 [SMILES: C=C(CO)C(=O)OCCc1cc(CCOC(=O)C(=C)CO)cc(-c2ccc(-c3ccc(CCCCF)cc3)cc2CC)c1] |
| 1γ-2-147 | 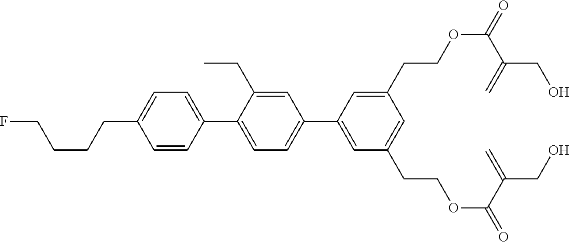 [SMILES: C=C(CO)C(=O)OCCc1cc(CCOC(=O)C(=C)CO)cc(-c2ccc(-c3ccc(CCCCF)cc3)c(CC)c2)c1] |
| 1γ-2-148 | 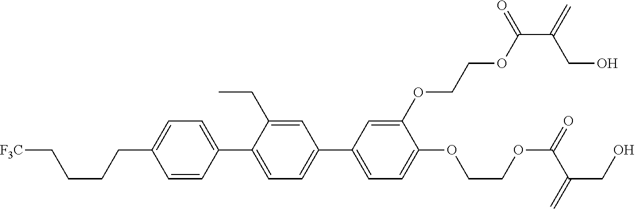 [SMILES: C=C(CO)C(=O)OCCOc1ccc(-c2ccc(-c3ccc(CCCCC(F)(F)F)cc3)c(CC)c2)cc1OCCOC(=O)C(=C)CO] |
| 1γ-2-149 | 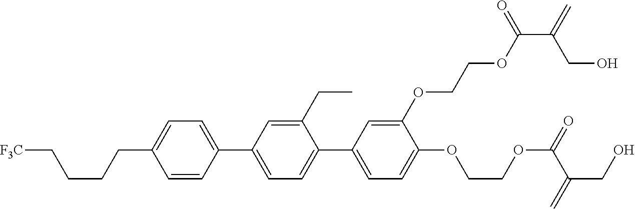 [SMILES: C=C(CO)C(=O)OCCOc1ccc(-c2ccc(-c3ccc(CCCCC(F)(F)F)cc3)cc2CC)cc1OCCOC(=O)C(=C)CO] |
| 1γ-2-150 | 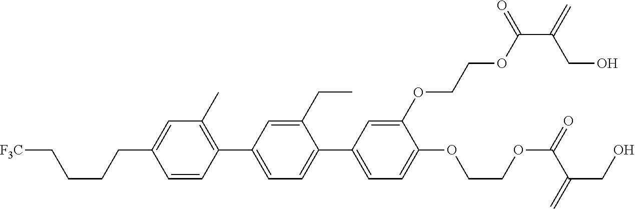 [SMILES: C=C(CO)C(=O)OCCOc1ccc(-c2ccc(-c3ccc(CCCCC(F)(F)F)cc3C)cc2CC)cc1OCCOC(=O)C(=C)CO] |
| 1γ-2-151 | 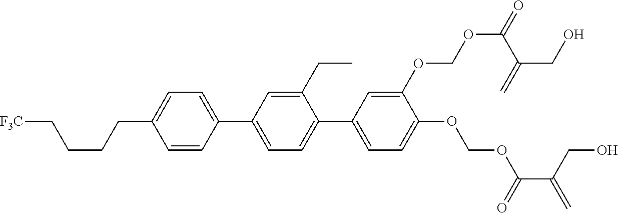 [SMILES: C=C(CO)C(=O)OCOc1ccc(-c2ccc(-c3ccc(CCCCC(F)(F)F)cc3)cc2CC)cc1OCOC(=O)C(=C)CO] |
| 1γ-2-152 | 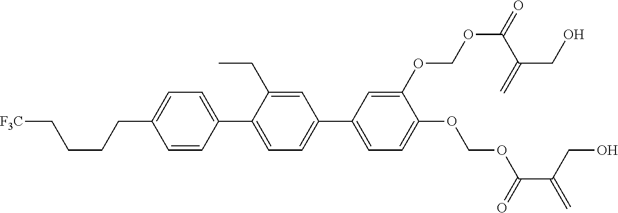 [SMILES: C=C(CO)C(=O)OCOc1ccc(-c2ccc(-c3ccc(CCCCC(F)(F)F)cc3)c(CC)c2)cc1OCOC(=O)C(=C)CO] |
| 1γ-2-153 | 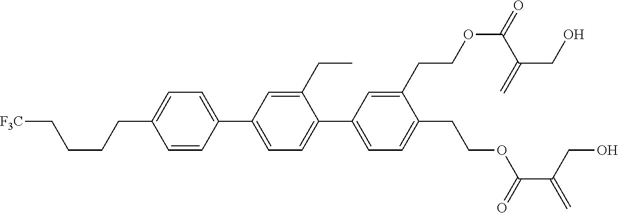 [SMILES: C=C(CO)C(=O)OCCc1ccc(-c2ccc(-c3ccc(CCCCC(F)(F)F)cc3)cc2CC)cc1CCOC(=O)C(=C)CO] |
| 1γ-2-154 | 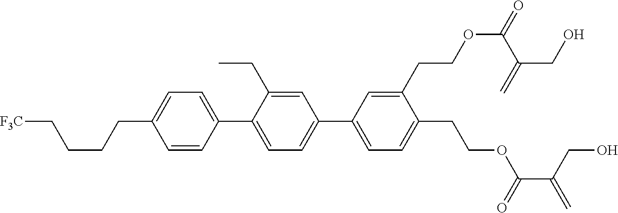 [SMILES: C=C(CO)C(=O)OCCc1ccc(-c2ccc(-c3ccc(CCCCC(F)(F)F)cc3)c(CC)c2)cc1CCOC(=O)C(=C)CO] |
| 1γ-2-155 | 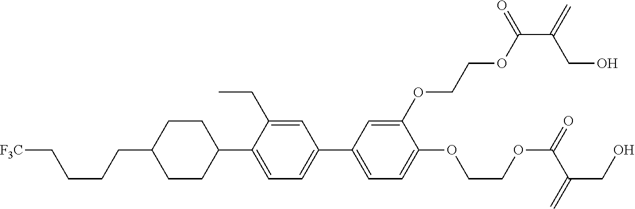 [SMILES: C=C(CO)C(=O)OCCOc1ccc(-c2ccc(C3CCC(CCCCC(F)(F)F)CC3)c(CC)c2)cc1OCCOC(=O)C(=C)CO] |
| 1γ-2-156 | 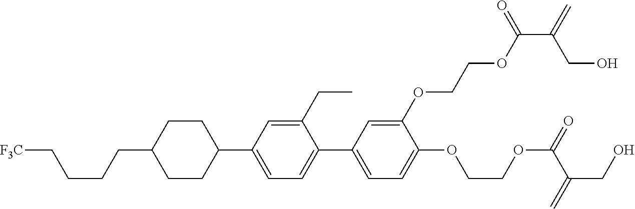 [SMILES: C=C(CO)C(=O)OCCOc1ccc(-c2ccc(C3CCC(CCCCC(F)(F)F)CC3)cc2CC)cc1OCCOC(=O)C(=C)CO] |
| 1γ-2-157 | 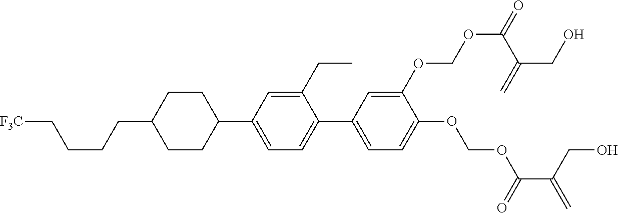 [SMILES: C=C(CO)C(=O)OCOc1ccc(-c2ccc(C3CCC(CCCCC(F)(F)F)CC3)cc2CC)cc1OCOC(=O)C(=C)CO] |
| 1γ-2-158 | 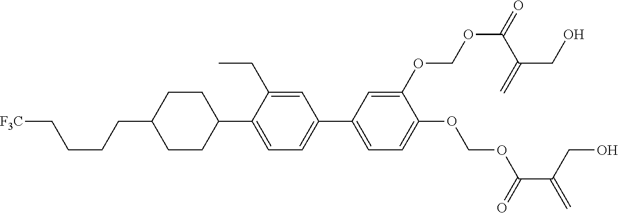 [SMILES: C=C(CO)C(=O)OCOc1ccc(-c2ccc(C3CCC(CCCCC(F)(F)F)CC3)c(CC)c2)cc1OCOC(=O)C(=C)CO] |
| 1γ-2-159 | 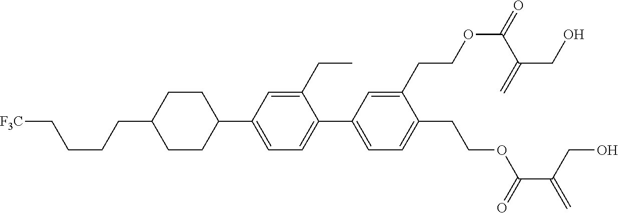 [SMILES: C=C(CO)C(=O)OCCc1ccc(-c2ccc(C3CCC(CCCCC(F)(F)F)CC3)cc2CC)cc1CCOC(=O)C(=C)CO] |
| 1γ-2-160 | 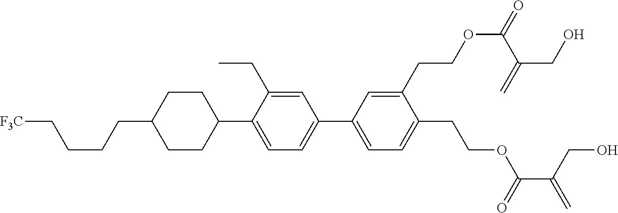 [SMILES: C=C(CO)C(=O)OCCc1ccc(-c2ccc(C3CCC(CCCCC(F)(F)F)CC3)c(CC)c2)cc1CCOC(=O)C(=C)CO] |
| 1γ-2-161 | 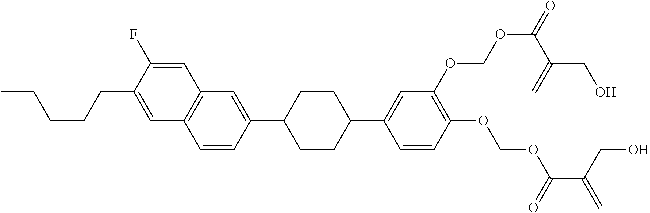 [SMILES: C=C(CO)C(=O)OCOc1ccc(C2CCC(c3ccc4cc(CCCCC)c(F)cc4c3)CC2)cc1OCOC(=O)C(=C)CO] |
| 1γ-2-162 | 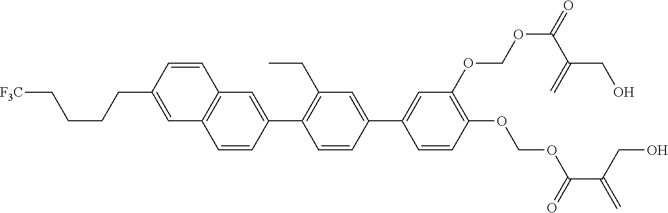 [SMILES: C=C(CO)C(=O)OCOc1ccc(-c2ccc(-c3ccc4cc(CCCCC(F)(F)F)ccc4c3)c(CC)c2)cc1OCOC(=O)C(=C)CO] |
| 1γ-2-163 | 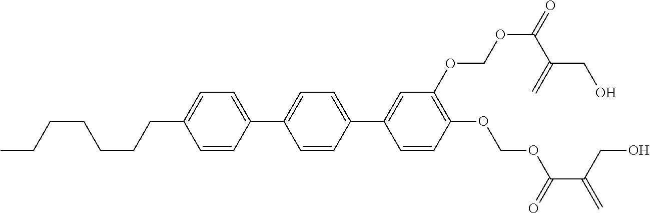 [SMILES: C=C(CO)C(=O)OCOc1ccc(-c2ccc(-c3ccc(CCCCCCC)cc3)cc2)cc1OCOC(=O)C(=C)CO] |
| 1γ-2-164 | 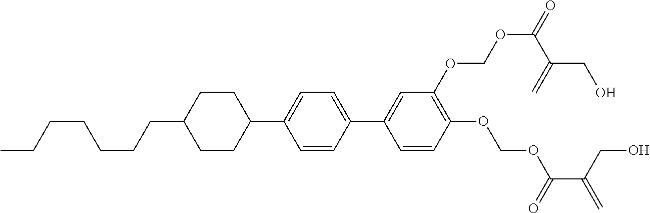 [SMILES: C=C(CO)C(=O)OCOc1ccc(-c2ccc(C3CCC(CCCCCCC)CC3)cc2)cc1OCOC(=O)C(=C)CO] |
| 1γ-2-165 | 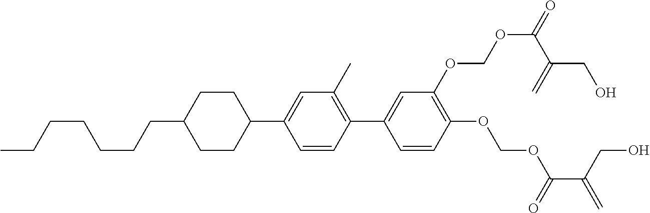 [SMILES: C=C(CO)C(=O)OCOc1ccc(-c2ccc(C3CCC(CCCCCCC)CC3)cc2C)cc1OCOC(=O)C(=C)CO] |
| 1γ-2-166 | 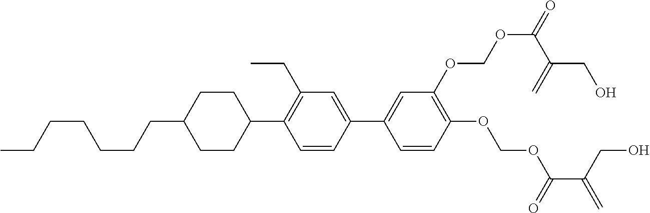 [SMILES: C=C(CO)C(=O)OCOc1ccc(-c2ccc(C3CCC(CCCCCCC)CC3)c(CC)c2)cc1OCOC(=O)C(=C)CO] |
| 1γ-2-167 | 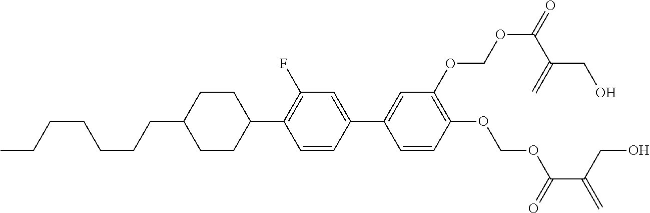 [SMILES: C=C(CO)C(=O)OCOc1ccc(-c2ccc(C3CCC(CCCCCCC)CC3)c(F)c2)cc1OCOC(=O)C(=C)CO] |
| 1γ-2-168 | 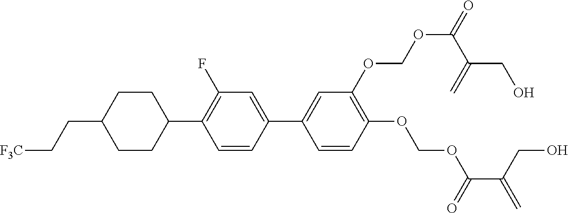 [SMILES: C=C(CO)C(=O)OCOc1ccc(-c2ccc(C3CCC(CCC(F)(F)F)CC3)c(F)c2)cc1OCOC(=O)C(=C)CO] |
| 1γ-2-169 | 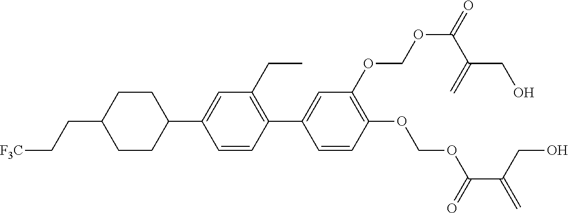 [SMILES: C=C(CO)C(=O)OCOc1ccc(-c2ccc(C3CCC(CCC(F)(F)F)CC3)cc2CC)cc1OCOC(=O)C(=C)CO] |
| 1γ-2-170 | 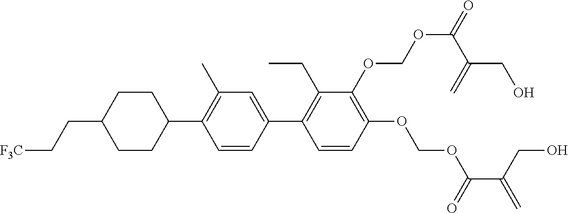 [SMILES: C=C(CO)C(=O)OCOc1ccc(-c2ccc(C3CCC(CCC(F)(F)F)CC3)c(C)c2)c(CC)c1OCOC(=O)C(=C)CO] |
| 1γ-2-171 | 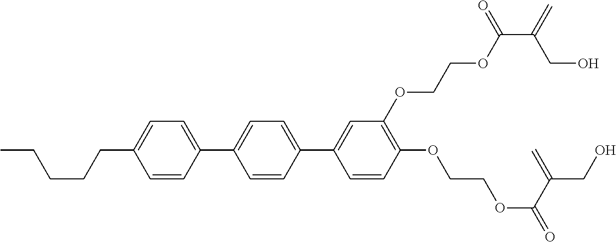 [SMILES: C=C(CO)C(=O)OCCOc1ccc(-c2ccc(-c3ccc(CCCCC)cc3)cc2)cc1OCCOC(=O)C(=C)CO] |
| 1γ-2-172 | 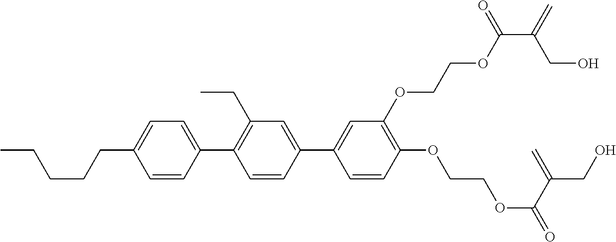 [SMILES: C=C(CO)C(=O)OCCOc1ccc(-c2ccc(-c3ccc(CCCCC)cc3)c(CC)c2)cc1OCCOC(=O)C(=C)CO] |
| 1γ-2-173 | 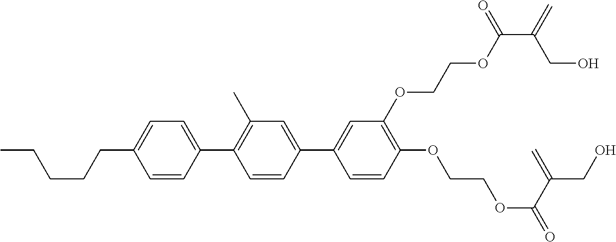 [SMILES: C=C(CO)C(=O)OCCOc1ccc(-c2ccc(-c3ccc(CCCCC)cc3)c(C)c2)cc1OCCOC(=O)C(=C)CO] |
| 1γ-2-174 | 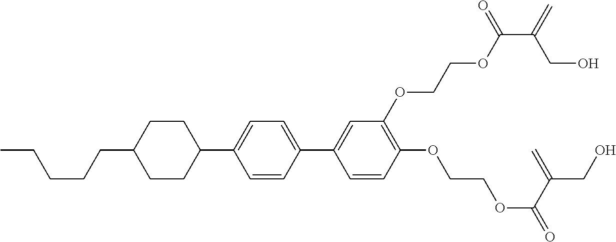 [SMILES: C=C(CO)C(=O)OCCOc1ccc(-c2ccc(C3CCC(CCCCC)CC3)cc2)cc1OCCOC(=O)C(=C)CO] |
| 1γ-2-175 | 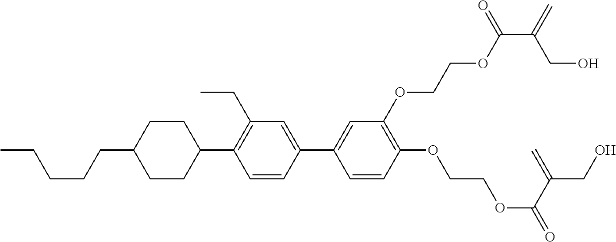 [SMILES: C=C(CO)C(=O)OCCOc1ccc(-c2ccc(C3CCC(CCCCC)CC3)c(CC)c2)cc1OCCOC(=O)C(=C)CO] |
| 1γ-2-176 | 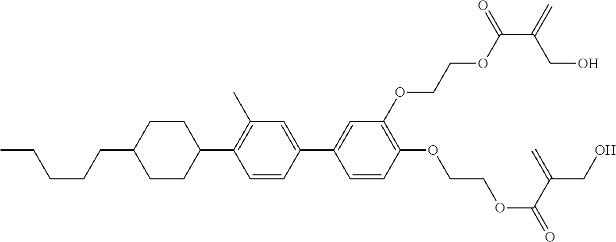 [SMILES: C=C(CO)C(=O)OCCOc1ccc(-c2ccc(C3CCC(CCCCC)CC3)c(C)c2)cc1OCCOC(=O)C(=C)CO] |
| 1γ-2-177 | 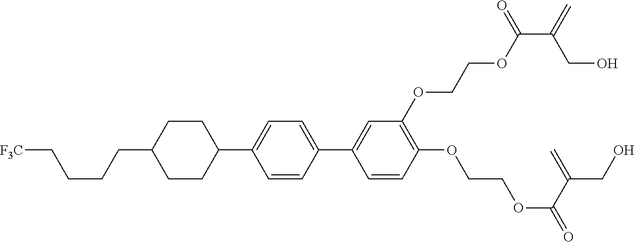 [SMILES: C=C(CO)C(=O)OCCOc1ccc(-c2ccc(C3CCC(CCCCC(F)(F)F)CC3)cc2)cc1OCCOC(=O)C(=C)CO] |
| 1γ-2-178 | 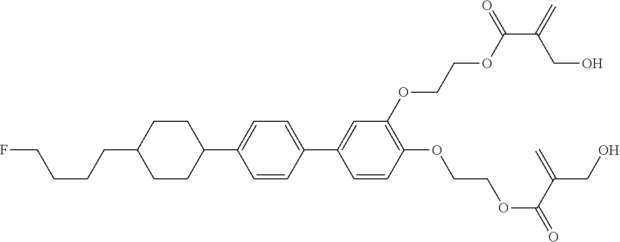 [SMILES: C=C(CO)C(=O)OCCOc1ccc(-c2ccc(C3CCC(CCCCF)CC3)cc2)cc1OCCOC(=O)C(=C)CO] |
| 1γ-2-179 | 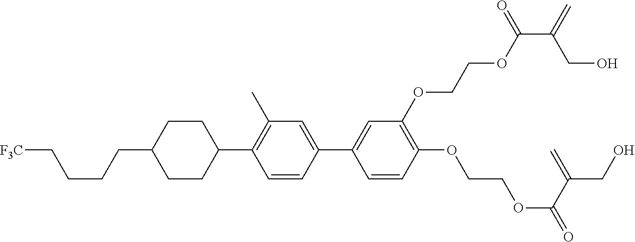 [SMILES: C=C(CO)C(=O)OCCOc1ccc(-c2ccc(C3CCC(CCCCC(F)(F)F)CC3)c(C)c2)cc1OCCOC(=O)C(=C)CO] |
| 1γ-2-180 | 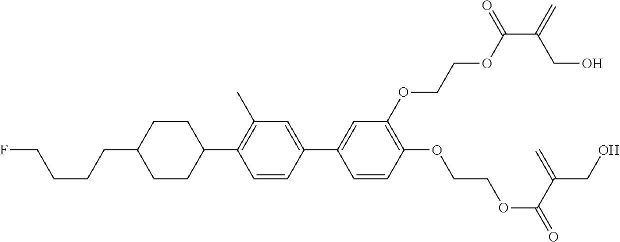 [SMILES: C=C(CO)C(=O)OCCOc1ccc(-c2ccc(C3CCC(CCCCF)CC3)c(C)c2)cc1OCCOC(=O)C(=C)CO] |
| 1γ-2-181 | 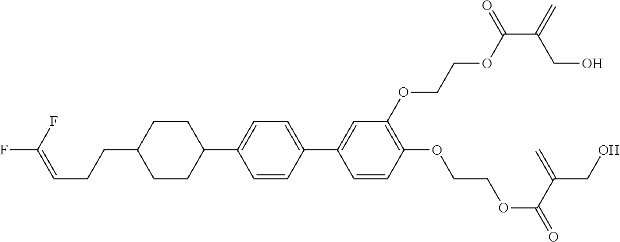 [SMILES: C=C(CO)C(=O)OCCOc1ccc(-c2ccc(C3CCC(CCC=C(F)F)CC3)cc2)cc1OCCOC(=O)C(=C)CO] |
| 1γ-2-182 | 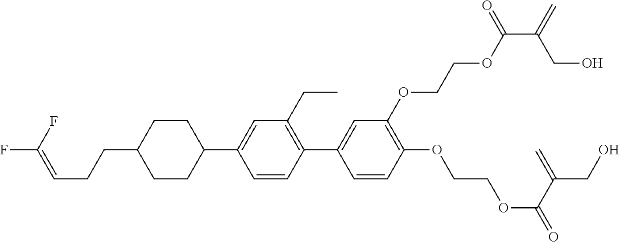 [SMILES: C=C(CO)C(=O)OCCOc1ccc(-c2ccc(C3CCC(CCC=C(F)F)CC3)cc2CC)cc1OCCOC(=O)C(=C)CO] |
| 1γ-2-183 | 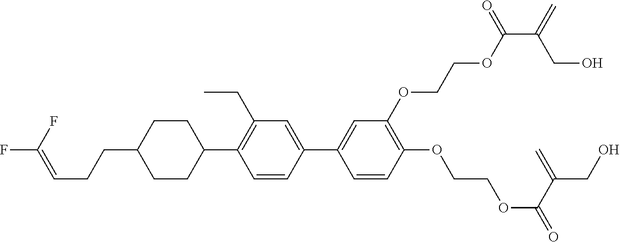 [SMILES: C=C(CO)C(=O)OCCOc1ccc(-c2ccc(C3CCC(CCC=C(F)F)CC3)c(CC)c2)cc1OCCOC(=O)C(=C)CO] |
| 1γ-2-184 | 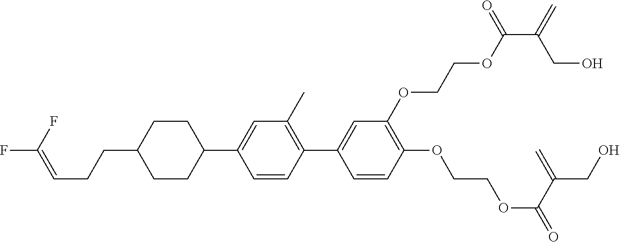 [SMILES: C=C(CO)C(=O)OCCOc1ccc(-c2ccc(C3CCC(CCC=C(F)F)CC3)cc2C)cc1OCCOC(=O)C(=C)CO] |
| 1γ-2-185 | 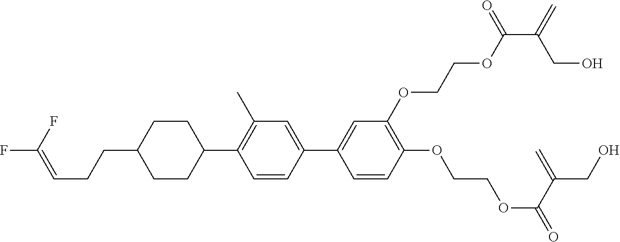 [SMILES: C=C(CO)C(=O)OCCOc1ccc(-c2ccc(C3CCC(CCC=C(F)F)CC3)c(C)c2)cc1OCCOC(=O)C(=C)CO] |
| 1γ-2-186 | 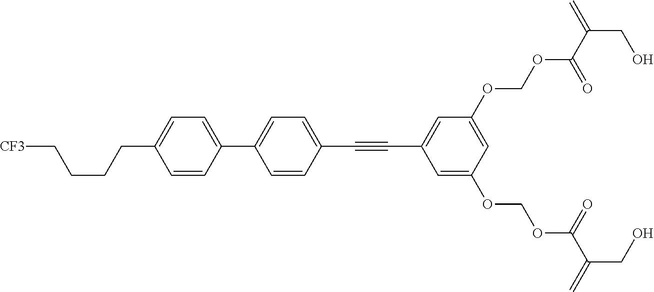 [SMILES: C=C(CO)C(=O)OCOc1cc(C#Cc2ccc(-c3ccc(CCCCC(F)(F)F)cc3)cc2)cc(OCOC(=O)C(=C)CO)c1] |
| 1γ-2-187 | 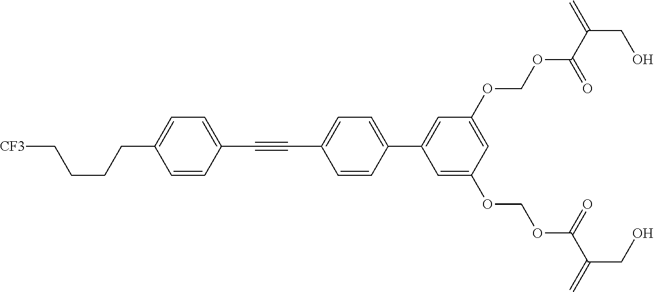 [SMILES: C=C(CO)C(=O)OCOc1cc(OCOC(=O)C(=C)CO)cc(-c2ccc(C#Cc3ccc(CCCCC(F)(F)F)cc3)cc2)c1] |
| 1γ-2-188 | 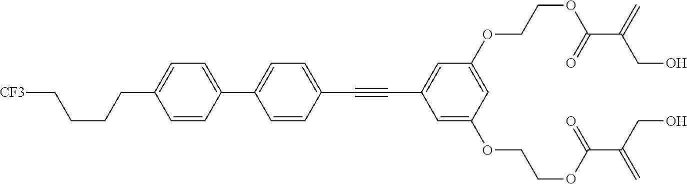 [SMILES: C=C(CO)C(=O)OCCOc1cc(C#Cc2ccc(-c3ccc(CCCCC(F)(F)F)cc3)cc2)cc(OCCOC(=O)C(=C)CO)c1] |
| 1γ-2-189 | 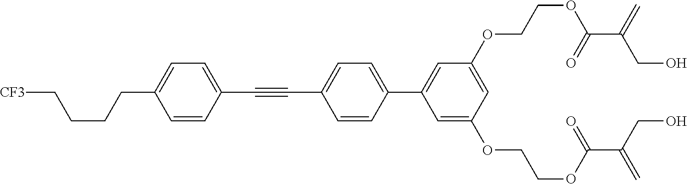 [SMILES: C=C(CO)C(=O)OCCOc1cc(OCCOC(=O)C(=C)CO)cc(-c2ccc(C#Cc3ccc(CCCCC(F)(F)F)cc3)cc2)c1] |
| 1γ-2-190 | 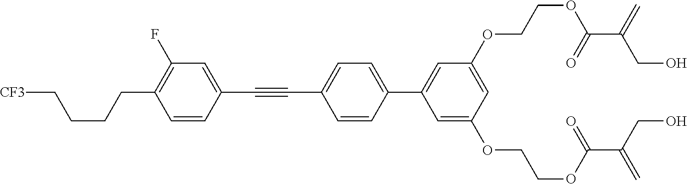 [SMILES: C=C(CO)C(=O)OCCOc1cc(OCCOC(=O)C(=C)CO)cc(-c2ccc(C#Cc3ccc(CCCCC(F)(F)F)c(F)c3)cc2)c1] |
| 1γ-2-191 | 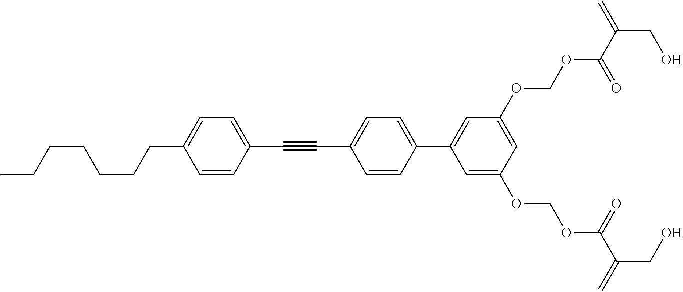 [SMILES: C=C(CO)C(=O)OCOc1cc(OCOC(=O)C(=C)CO)cc(-c2ccc(C#Cc3ccc(CCCCCCC)cc3)cc2)c1] |
| 1γ-2-192 | 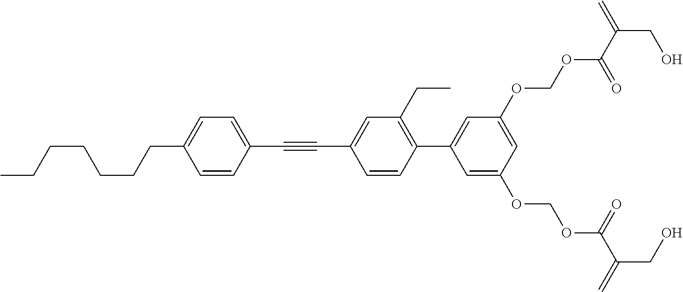 [SMILES: C=C(CO)C(=O)OCOc1cc(OCOC(=O)C(=C)CO)cc(-c2ccc(C#Cc3ccc(CCCCCCC)cc3)cc2CC)c1] |
| 1γ-2-193 | 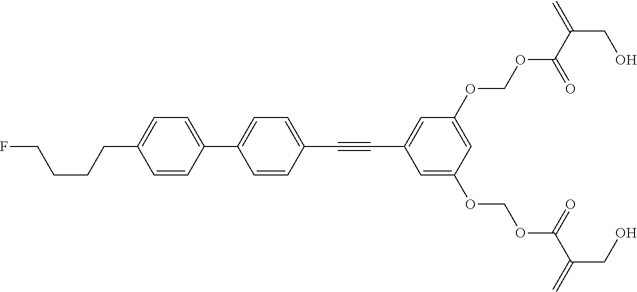 [SMILES: C=C(CO)C(=O)OCOc1cc(C#Cc2ccc(-c3ccc(CCCCF)cc3)cc2)cc(OCOC(=O)C(=C)CO)c1] |
| 1γ-2-194 | 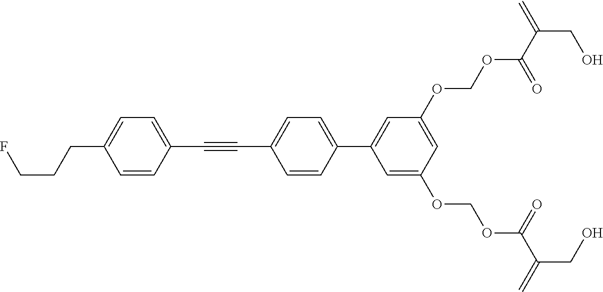 [SMILES: C=C(CO)C(=O)OCOc1cc(OCOC(=O)C(=C)CO)cc(-c2ccc(C#Cc3ccc(CCCF)cc3)cc2)c1] |
| 1γ-2-195 | 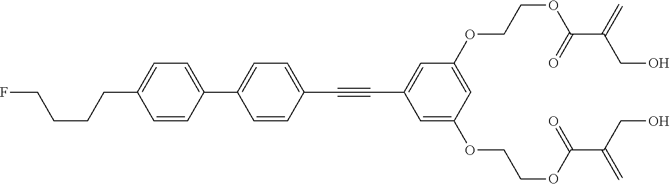 [SMILES: C=C(CO)C(=O)OCCOc1cc(C#Cc2ccc(-c3ccc(CCCCF)cc3)cc2)cc(OCCOC(=O)C(=C)CO)c1] |
| 1γ-2-196 | 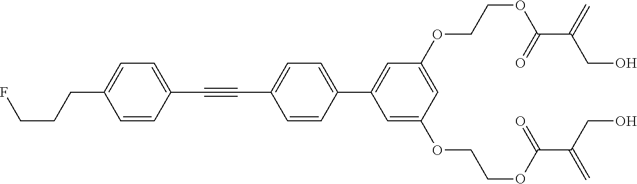 [SMILES: C=C(CO)C(=O)OCCOc1cc(OCCOC(=O)C(=C)CO)cc(-c2ccc(C#Cc3ccc(CCCF)cc3)cc2)c1] |
| 1γ-2-197 | 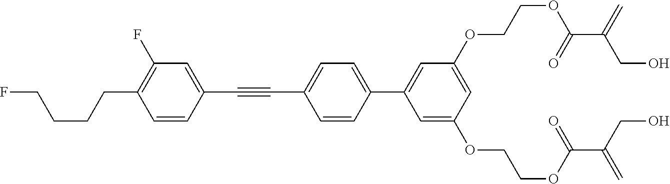 [SMILES: C=C(CO)C(=O)OCCOc1cc(OCCOC(=O)C(=C)CO)cc(-c2ccc(C#Cc3ccc(CCCCF)c(F)c3)cc2)c1] |
| 1γ-2-198 | 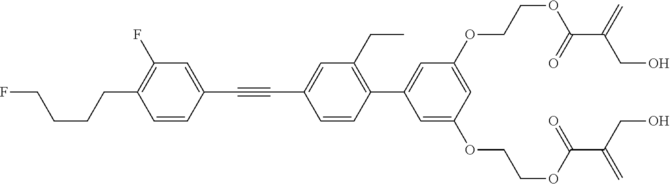 [SMILES: C=C(CO)C(=O)OCCOc1cc(OCCOC(=O)C(=C)CO)cc(-c2ccc(C#Cc3ccc(CCCCF)c(F)c3)cc2CC)c1] |
| 1γ-2-199 | 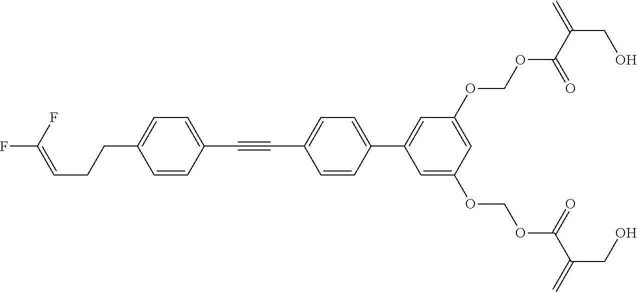 [SMILES: C=C(CO)C(=O)OCOc1cc(OCOC(=O)C(=C)CO)cc(-c2ccc(C#Cc3ccc(CCC=C(F)F)cc3)cc2)c1] |
| 1γ-2-200 | 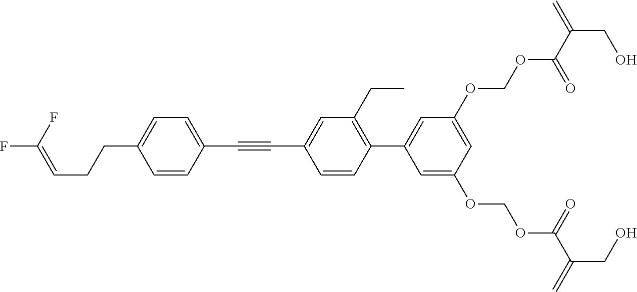 [SMILES: C=C(CO)C(=O)OCOc1cc(OCOC(=O)C(=C)CO)cc(-c2ccc(C#Cc3ccc(CCC=C(F)F)cc3)cc2CC)c1] |
| 1γ-2-201 | 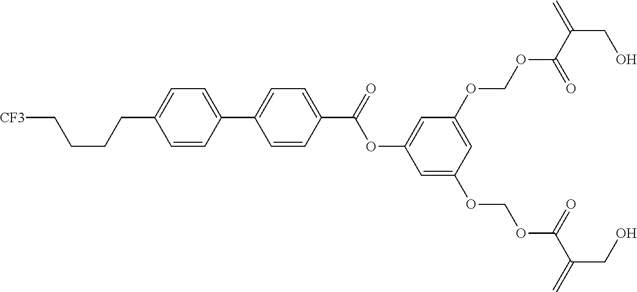 [SMILES: C=C(CO)C(=O)OCOc1cc(OCOC(=O)C(=C)CO)cc(OC(=O)c2ccc(-c3ccc(CCCCC(F)(F)F)cc3)cc2)c1] |
| 1γ-2-202 | 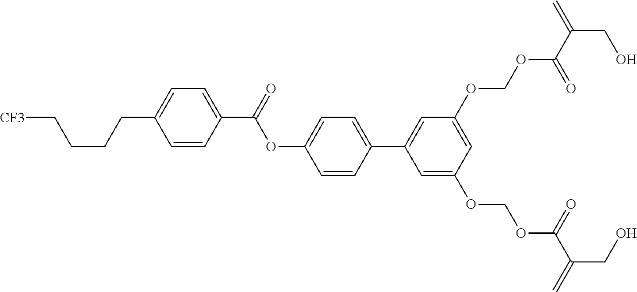 [SMILES: C=C(CO)C(=O)OCOc1cc(OCOC(=O)C(=C)CO)cc(-c2ccc(OC(=O)c3ccc(CCCCC(F)(F)F)cc3)cc2)c1] |
| 1γ-2-203 | 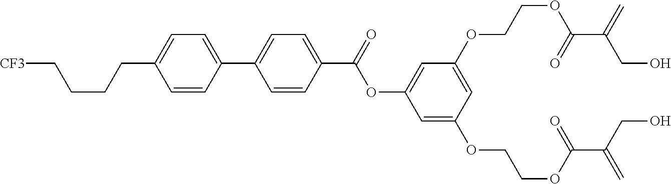 [SMILES: C=C(CO)C(=O)OCCOc1cc(OCCOC(=O)C(=C)CO)cc(OC(=O)c2ccc(-c3ccc(CCCCC(F)(F)F)cc3)cc2)c1] |
| 1γ-2-204 | 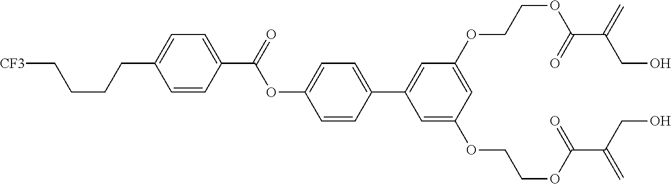 [SMILES: C=C(CO)C(=O)OCCOc1cc(OCCOC(=O)C(=C)CO)cc(-c2ccc(OC(=O)c3ccc(CCCCC(F)(F)F)cc3)cc2)c1] |
| 1γ-2-205 | 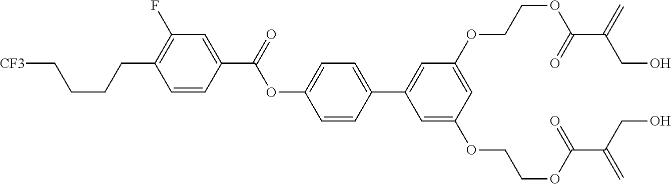 [SMILES: C=C(CO)C(=O)OCCOc1cc(OCCOC(=O)C(=C)CO)cc(-c2ccc(OC(=O)c3ccc(CCCCC(F)(F)F)c(F)c3)cc2)c1] |
| 1γ-2-206 | 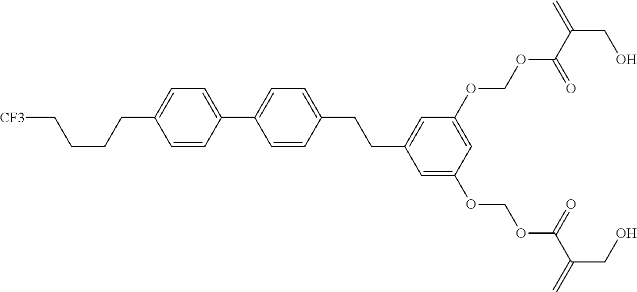 [SMILES: C=C(CO)C(=O)OCOc1cc(CCc2ccc(-c3ccc(CCCCC(F)(F)F)cc3)cc2)cc(OCOC(=O)C(=C)CO)c1] |
| 1γ-2-207 | 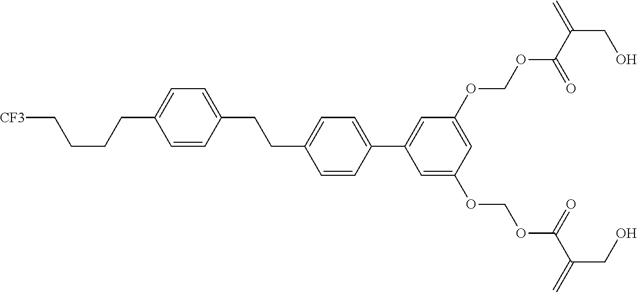 [SMILES: C=C(CO)C(=O)OCOc1cc(OCOC(=O)C(=C)CO)cc(-c2ccc(CCc3ccc(CCCCC(F)(F)F)cc3)cc2)c1] |
| 1γ-2-208 | 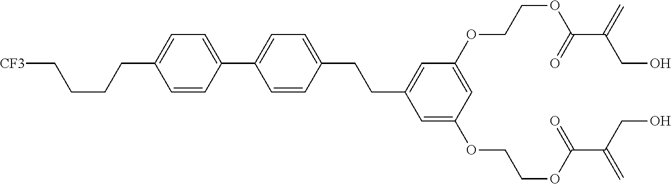 [SMILES: C=C(CO)C(=O)OCCOc1cc(CCc2ccc(-c3ccc(CCCCC(F)(F)F)cc3)cc2)cc(OCCOC(=O)C(=C)CO)c1] |
| 1γ-2-209 | 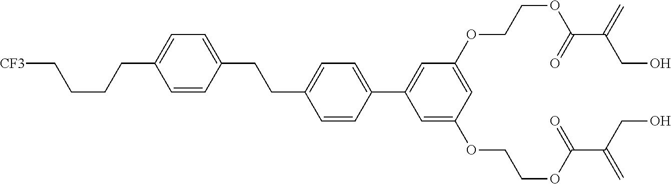 [SMILES: C=C(CO)C(=O)OCCOc1cc(OCCOC(=O)C(=C)CO)cc(-c2ccc(CCc3ccc(CCCCC(F)(F)F)cc3)cc2)c1] |
| 1γ-2-210 | 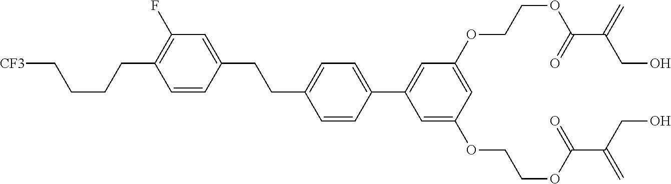 [SMILES: C=C(CO)C(=O)OCCOc1cc(OCCOC(=O)C(=C)CO)cc(-c2ccc(CCc3ccc(CCCCC(F)(F)F)c(F)c3)cc2)c1] |
| 1γ-2-211 | 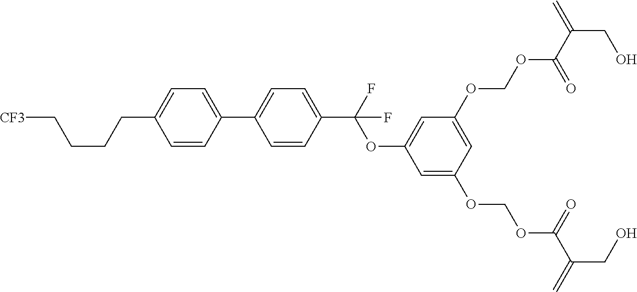 [SMILES: C=C(CO)C(=O)OCOc1cc(OCOC(=O)C(=C)CO)cc(OC(F)(F)c2ccc(-c3ccc(CCCCC(F)(F)F)cc3)cc2)c1] |
| 1γ-2-212 | 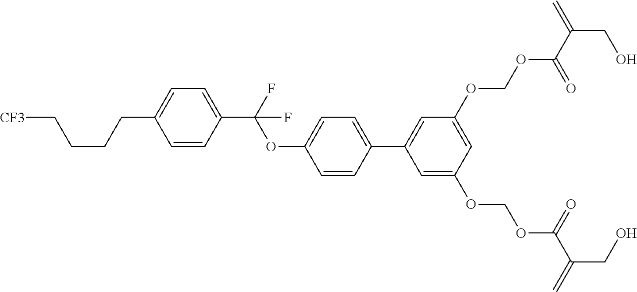 [SMILES: C=C(CO)C(=O)OCOc1cc(OCOC(=O)C(=C)CO)cc(-c2ccc(OC(F)(F)c3ccc(CCCCC(F)(F)F)cc3)cc2)c1] |
| 1γ-2-213 | 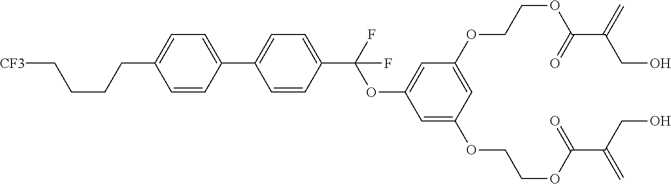 [SMILES: C=C(CO)C(=O)OCCOc1cc(OCCOC(=O)C(=C)CO)cc(OC(F)(F)c2ccc(-c3ccc(CCCCC(F)(F)F)cc3)cc2)c1] |
| 1γ-2-214 | 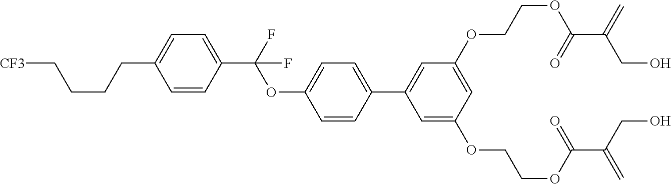 [SMILES: C=C(CO)C(=O)OCCOc1cc(OCCOC(=O)C(=C)CO)cc(-c2ccc(OC(F)(F)c3ccc(CCCCC(F)(F)F)cc3)cc2)c1] |
| 1γ-2-215 | 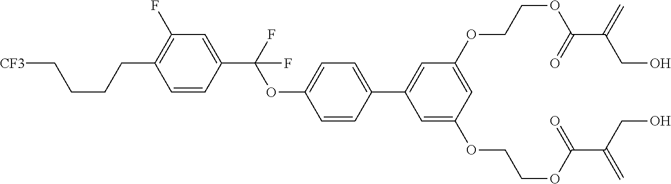 [SMILES: C=C(CO)C(=O)OCCOc1cc(OCCOC(=O)C(=C)CO)cc(-c2ccc(OC(F)(F)c3ccc(CCCCC(F)(F)F)c(F)c3)cc2)c1] |
| 1γ-2-216 | 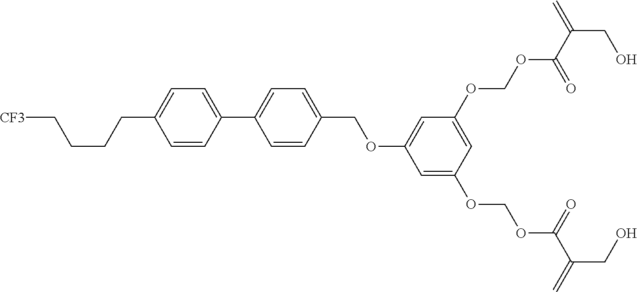 [SMILES: C=C(CO)C(=O)OCOc1cc(OCOC(=O)C(=C)CO)cc(OCc2ccc(-c3ccc(CCCCC(F)(F)F)cc3)cc2)c1] |
| 1γ-2-217 | 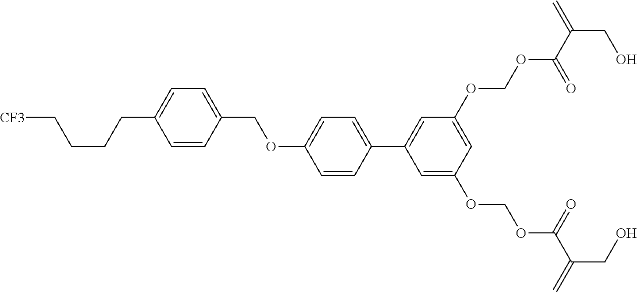 [SMILES: C=C(CO)C(=O)OCOc1cc(OCOC(=O)C(=C)CO)cc(-c2ccc(OCc3ccc(CCCCC(F)(F)F)cc3)cc2)c1] |
| 1γ-2-218 | 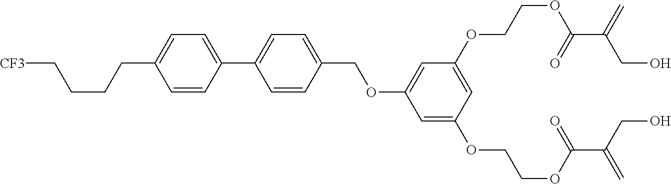 [SMILES: C=C(CO)C(=O)OCCOc1cc(OCCOC(=O)C(=C)CO)cc(OCc2ccc(-c3ccc(CCCCC(F)(F)F)cc3)cc2)c1] |
| 1γ-2-219 | 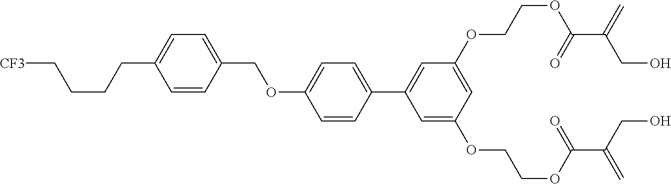 [SMILES: C=C(CO)C(=O)OCCOc1cc(OCCOC(=O)C(=C)CO)cc(-c2ccc(OCc3ccc(CCCCC(F)(F)F)cc3)cc2)c1] |
| 1γ-2-220 | 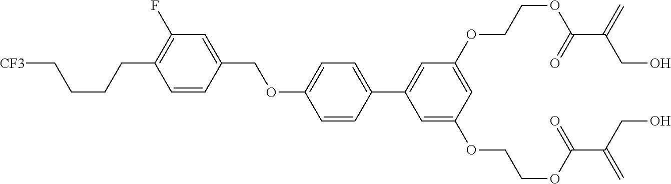 [SMILES: C=C(CO)C(=O)OCCOc1cc(OCCOC(=O)C(=C)CO)cc(-c2ccc(OCc3ccc(CCCCC(F)(F)F)c(F)c3)cc2)c1] |
| 1γ-2-221 | 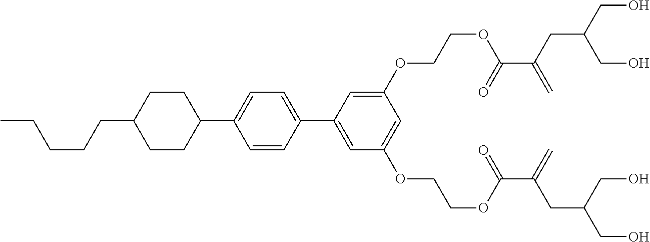 [SMILES: C=C(CC(CO)CO)C(=O)OCCOc1cc(OCCOC(=O)C(=C)CC(CO)CO)cc(-c2ccc(C3CCC(CCCCC)CC3)cc2)c1] |
| 1γ-2-222 | 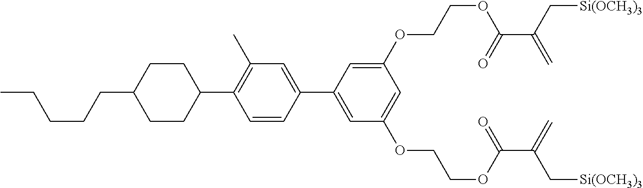 |
| 1γ-2-223 | 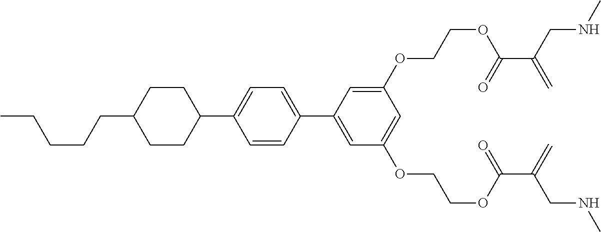 [SMILES: C=C(CNC)C(=O)OCCOc1cc(OCCOC(=O)C(=C)CNC)cc(-c2ccc(C3CCC(CCCCC)CC3)cc2)c1] |
| 1γ-2-224 | 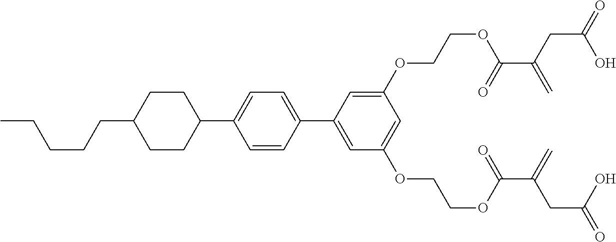 [SMILES: C=C(CC(=O)O)C(=O)OCCOc1cc(OCCOC(=O)C(=C)CC(=O)O)cc(-c2ccc(C3CCC(CCCCC)CC3)cc2)c1] |
| 1γ-2-225 | 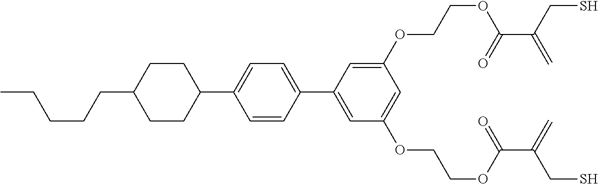 [SMILES: C=C(CS)C(=O)OCCOc1cc(OCCOC(=O)C(=C)CS)cc(-c2ccc(C3CCC(CCCCC)CC3)cc2)c1] |
| 1γ-3-1 | 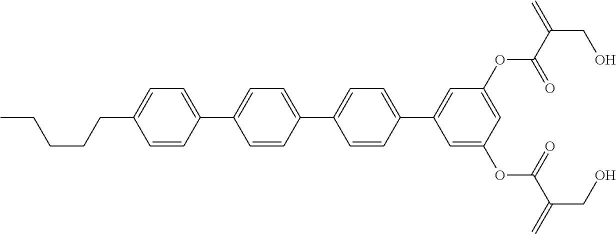 [SMILES: C=C(CO)C(=O)Oc1cc(OC(=O)C(=C)CO)cc(-c2ccc(-c3ccc(-c4ccc(CCCCC)cc4)cc3)cc2)c1] |
| 1γ-3-2 | 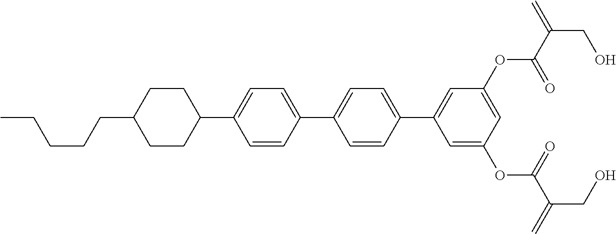 [SMILES: C=C(CO)C(=O)Oc1cc(OC(=O)C(=C)CO)cc(-c2ccc(-c3ccc(C4CCC(CCCCC)CC4)cc3)cc2)c1] |
| 1γ-3-3 | 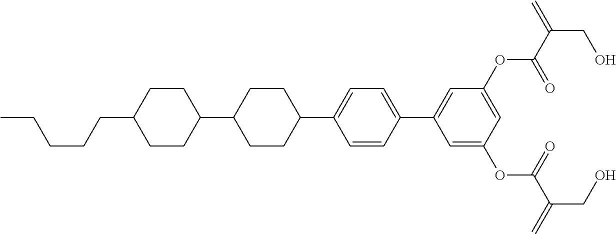 [SMILES: C=C(CO)C(=O)Oc1cc(OC(=O)C(=C)CO)cc(-c2ccc(C3CCC(C4CCC(CCCCC)CC4)CC3)cc2)c1] |
| 1γ-3-4 | 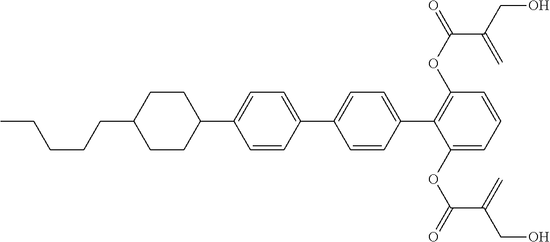 [SMILES: C=C(CO)C(=O)Oc1cccc(OC(=O)C(=C)CO)c1-c1ccc(-c2ccc(C3CCC(CCCCC)CC3)cc2)cc1] |
| 1γ-3-5 | 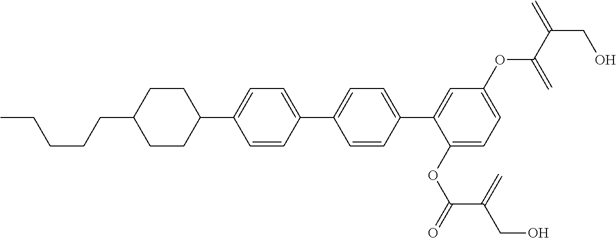 [SMILES: C=C(CO)C(=C)Oc1ccc(OC(=O)C(=C)CO)c(-c2ccc(-c3ccc(C4CCC(CCCCC)CC4)cc3)cc2)c1] |
| 1γ-3-6 | 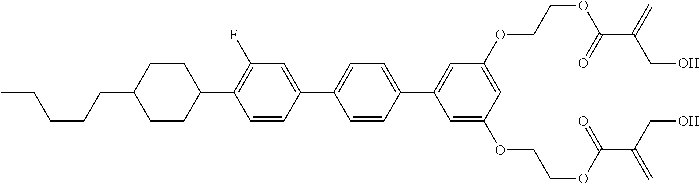 [SMILES: C=C(CO)C(=O)OCCOc1cc(OCCOC(=O)C(=C)CO)cc(-c2ccc(-c3ccc(C4CCC(CCCCC)CC4)c(F)c3)cc2)c1] |
| 1γ-3-7 | 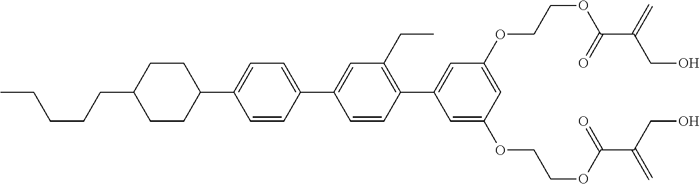 [SMILES: C=C(CO)C(=O)OCCOc1cc(OCCOC(=O)C(=C)CO)cc(-c2ccc(-c3ccc(C4CCC(CCCCC)CC4)cc3)cc2CC)c1] |
| 1γ-3-8 | 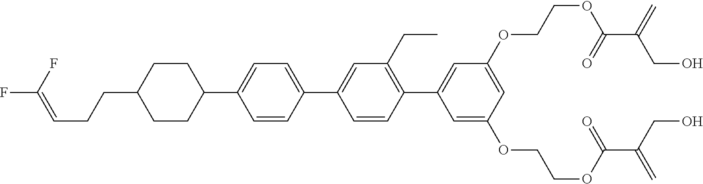 [SMILES: C=C(CO)C(=O)OCCOc1cc(OCCOC(=O)C(=C)CO)cc(-c2ccc(-c3ccc(C4CCC(CCC=C(F)F)CC4)cc3)cc2CC)c1] |
| 1γ-3-9 | 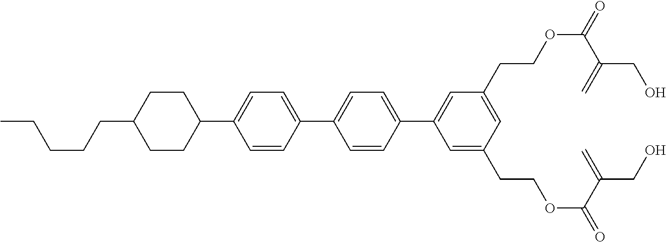 [SMILES: C=C(CO)C(=O)OCCc1cc(CCOC(=O)C(=C)CO)cc(-c2ccc(-c3ccc(C4CCC(CCCCC)CC4)cc3)cc2)c1] |
| 1γ-3-10 | 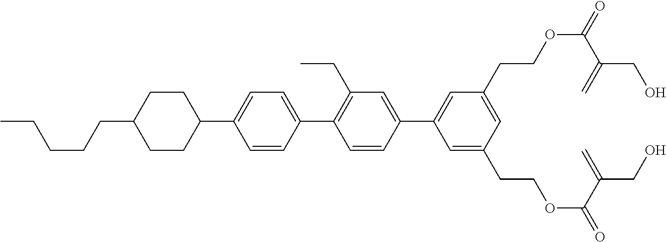 [SMILES: C=C(CO)C(=O)OCCc1cc(CCOC(=O)C(=C)CO)cc(-c2ccc(-c3ccc(C4CCC(CCCCC)CC4)cc3)c(CC)c2)c1] |
| 1γ-3-11 | 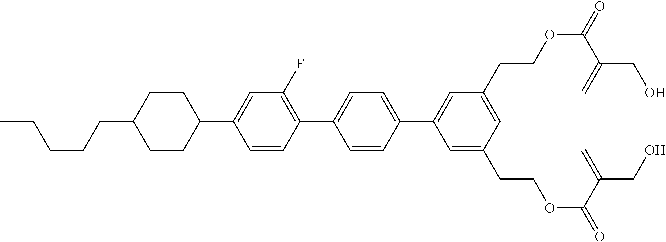 [SMILES: C=C(CO)C(=O)OCCc1cc(CCOC(=O)C(=C)CO)cc(-c2ccc(-c3ccc(C4CCC(CCCCC)CC4)cc3F)cc2)c1] |
| 1γ-3-12 | 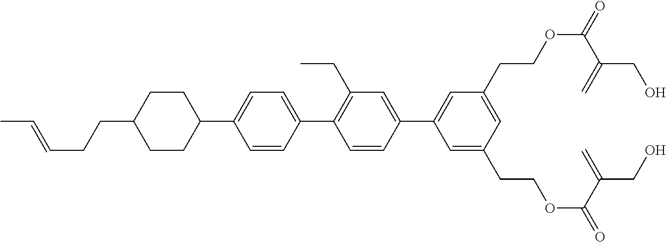 [SMILES: C=C(CO)C(=O)OCCc1cc(CCOC(=O)C(=C)CO)cc(-c2ccc(-c3ccc(C4CCC(CC/C=C/C)CC4)cc3)c(CC)c2)c1] |
| 1γ-3-13 | 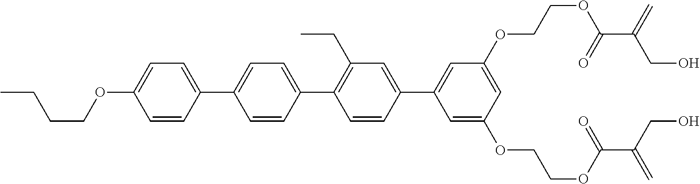 [SMILES: C=C(CO)C(=O)OCCOc1cc(OCCOC(=O)C(=C)CO)cc(-c2ccc(-c3ccc(-c4ccc(OCCCC)cc4)cc3)c(CC)c2)c1] |
| 1γ-3-14 | 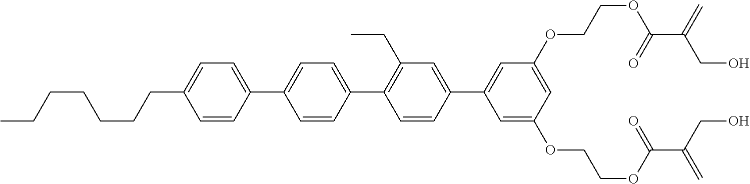 [SMILES: C=C(CO)C(=O)OCCOc1cc(OCCOC(=O)C(=C)CO)cc(-c2ccc(-c3ccc(-c4ccc(CCCCCCC)cc4)cc3)c(CC)c2)c1] |
| 1γ-3-15 | 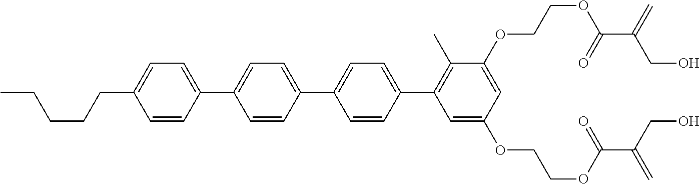 [SMILES: C=C(CO)C(=O)OCCOc1cc(OCCOC(=O)C(=C)CO)c(C)c(-c2ccc(-c3ccc(-c4ccc(CCCCC)cc4)cc3)cc2)c1] |
| 1γ-3-16 | 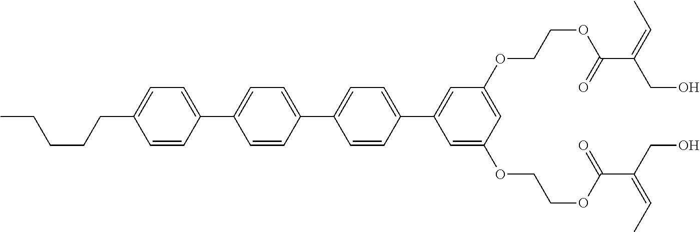 [SMILES: C/C=C(/CO)C(=O)OCCOc1cc(OCCOC(=O)/C(=C\C)CO)cc(-c2ccc(-c3ccc(-c4ccc(CCCCC)cc4)cc3)cc2)c1] |
| 1γ-3-17 | 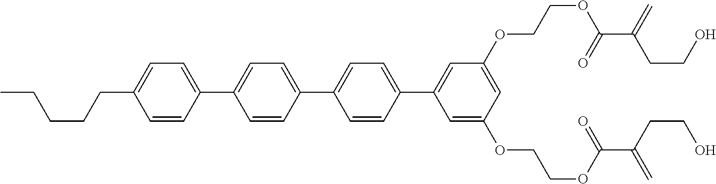 [SMILES: C=C(CCO)C(=O)OCCOc1cc(OCCOC(=O)C(=C)CCO)cc(-c2ccc(-c3ccc(-c4ccc(CCCCC)cc4)cc3)cc2)c1] |
| 1γ-3-18 | 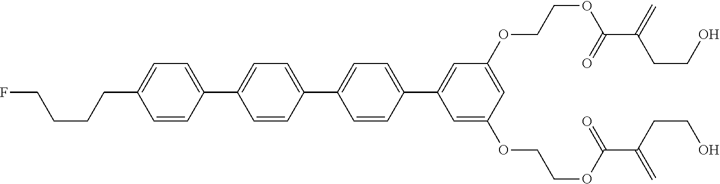 [SMILES: C=C(CCO)C(=O)OCCOc1cc(OCCOC(=O)C(=C)CCO)cc(-c2ccc(-c3ccc(-c4ccc(CCCCF)cc4)cc3)cc2)c1] |
| 1γ-3-19 | 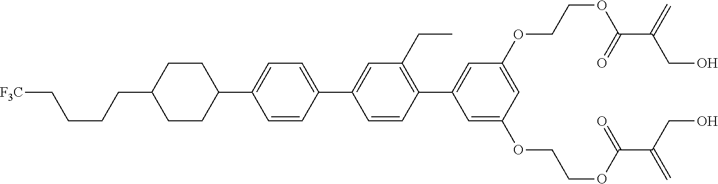 [SMILES: C=C(CO)C(=O)OCCOc1cc(OCCOC(=O)C(=C)CO)cc(-c2ccc(-c3ccc(C4CCC(CCCCC(F)(F)F)CC4)cc3)cc2CC)c1] |
| 1γ-3-20 | 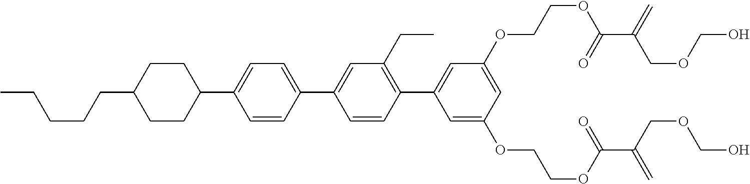 [SMILES: C=C(COCO)C(=O)OCCOc1cc(OCCOC(=O)C(=C)COCO)cc(-c2ccc(-c3ccc(C4CCC(CCCCC)CC4)cc3)cc2CC)c1] |
| 1γ-3-21 | 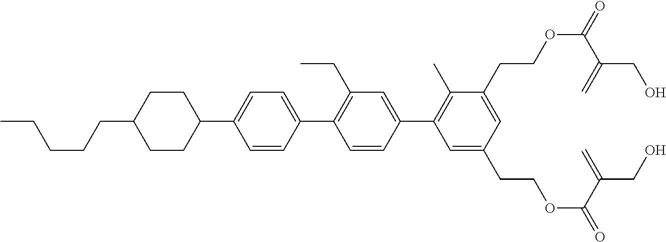 [SMILES: C=C(CO)C(=O)OCCc1cc(CCOC(=O)C(=C)CO)c(C)c(-c2ccc(-c3ccc(C4CCC(CCCCC)CC4)cc3)c(CC)c2)c1] |
| 1γ-3-22 | 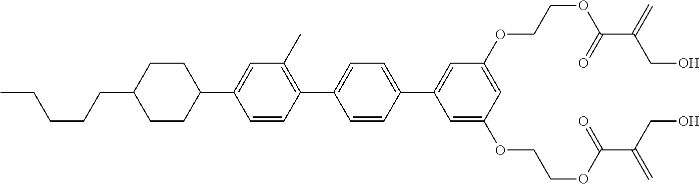 [SMILES: C=C(CO)C(=O)OCCOc1cc(OCCOC(=O)C(=C)CO)cc(-c2ccc(-c3ccc(C4CCC(CCCCC)CC4)cc3C)cc2)c1] |
| 1γ-3-23 | 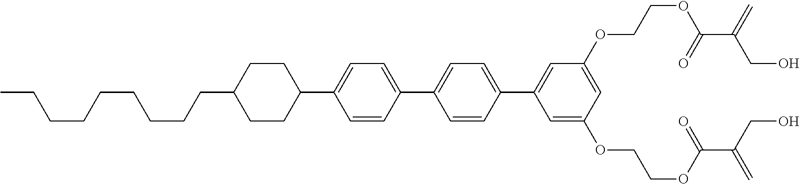 [SMILES: C=C(CO)C(=O)OCCOc1cc(OCCOC(=O)C(=C)CO)cc(-c2ccc(-c3ccc(C4CCC(CCCCCCCCC)CC4)cc3)cc2)c1] |
| 1γ-3-24 | 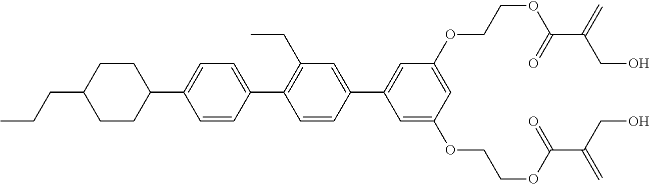 [SMILES: C=C(CO)C(=O)OCCOc1cc(OCCOC(=O)C(=C)CO)cc(-c2ccc(-c3ccc(C4CCC(CCC)CC4)cc3)c(CC)c2)c1] |
| 1γ-3-25 | 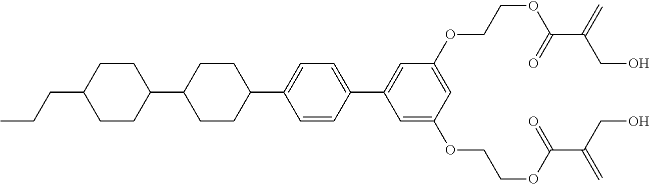 [SMILES: C=C(CO)C(=O)OCCOc1cc(OCCOC(=O)C(=C)CO)cc(-c2ccc(C3CCC(C4CCC(CCC)CC4)CC3)cc2)c1] |
| 1γ-3-26 | 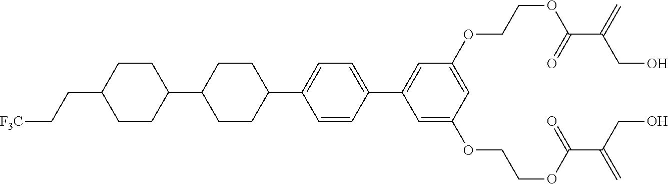 [SMILES: C=C(CO)C(=O)OCCOc1cc(OCCOC(=O)C(=C)CO)cc(-c2ccc(C3CCC(C4CCC(CCC(F)(F)F)CC4)CC3)cc2)c1] |
| 1γ-3-27 | 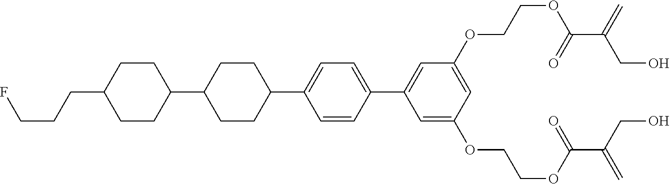 [SMILES: C=C(CO)C(=O)OCCOc1cc(OCCOC(=O)C(=C)CO)cc(-c2ccc(C3CCC(C4CCC(CCCF)CC4)CC3)cc2)c1] |
| 1γ-3-28 | 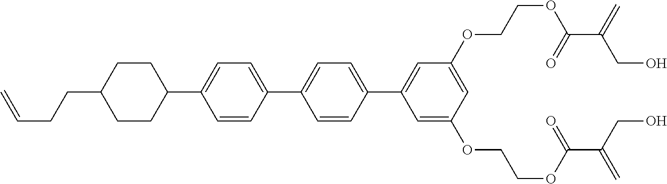 [SMILES: C=CCCC1CCC(c2ccc(-c3ccc(-c4cc(OCCOC(=O)C(=C)CO)cc(OCCOC(=O)C(=C)CO)c4)cc3)cc2)CC1] |
| 1γ-3-29 | 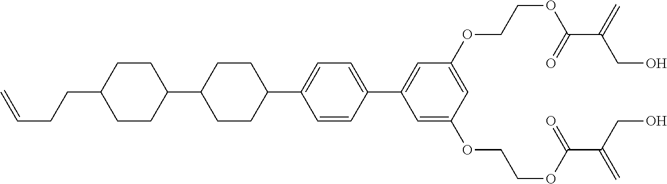 [SMILES: C=CCCC1CCC(C2CCC(c3ccc(-c4cc(OCCOC(=O)C(=C)CO)cc(OCCOC(=O)C(=C)CO)c4)cc3)CC2)CC1] |
| 1γ-3-30 | 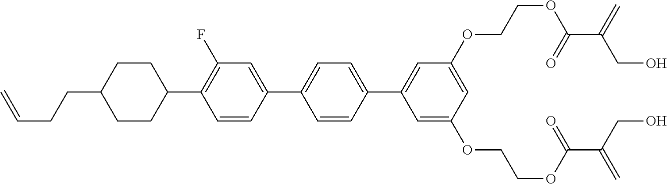 [SMILES: C=CCCC1CCC(c2ccc(-c3ccc(-c4cc(OCCOC(=O)C(=C)CO)cc(OCCOC(=O)C(=C)CO)c4)cc3)cc2F)CC1] |
| 1γ-3-31 | 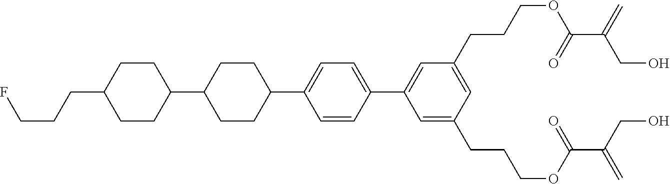 [SMILES: C=C(CO)C(=O)OCCCc1cc(CCCOC(=O)C(=C)CO)cc(-c2ccc(C3CCC(C4CCC(CCCF)CC4)CC3)cc2)c1] |
| 1γ-3-32 | 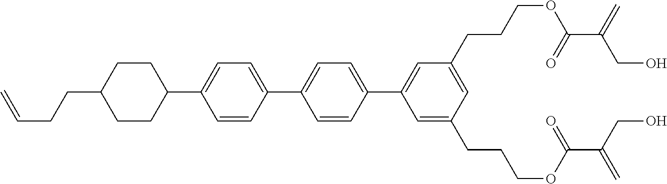 [SMILES: C=CCCC1CCC(c2ccc(-c3ccc(-c4cc(CCCOC(=O)C(=C)CO)cc(CCCOC(=O)C(=C)CO)c4)cc3)cc2)CC1] |
| 1γ-3-33 | 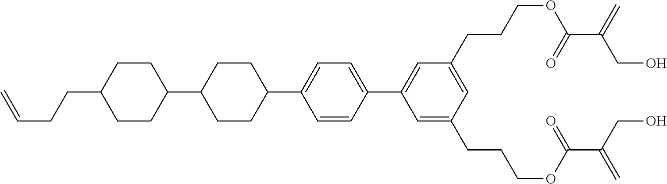 [SMILES: C=CCCC1CCC(C2CCC(c3ccc(-c4cc(CCCOC(=O)C(=C)CO)cc(CCCOC(=O)C(=C)CO)c4)cc3)CC2)CC1] |
| 1γ-3-34 | 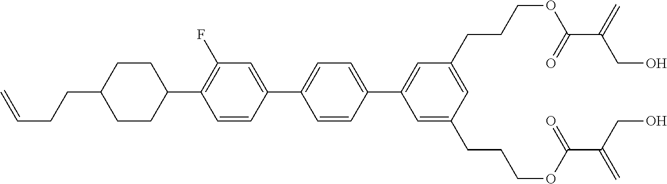 [SMILES: C=CCCC1CCC(c2ccc(-c3ccc(-c4cc(CCCOC(=O)C(=C)CO)cc(CCCOC(=O)C(=C)CO)c4)cc3)cc2F)CC1] |
| 1γ-3-35 | 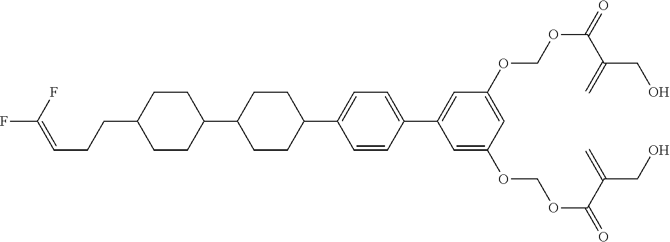 [SMILES: C=C(CO)C(=O)OCOc1cc(OCOC(=O)C(=C)CO)cc(-c2ccc(C3CCC(C4CCC(CCC=C(F)F)CC4)CC3)cc2)c1] |
| 1γ-3-36 | 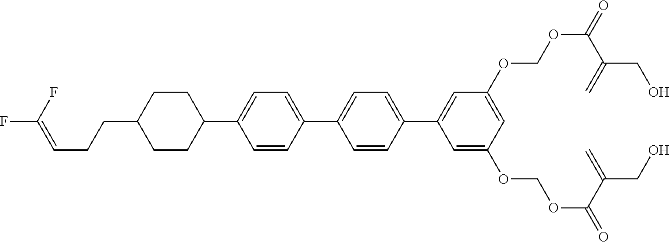 [SMILES: C=C(CO)C(=O)OCOc1cc(OCOC(=O)C(=C)CO)cc(-c2ccc(-c3ccc(C4CCC(CCC=C(F)F)CC4)cc3)cc2)c1] |
| 1γ-3-37 | 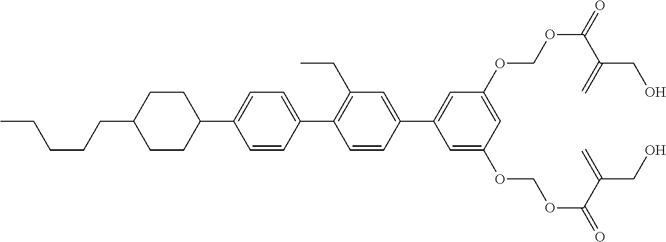 [SMILES: C=C(CO)C(=O)OCOc1cc(OCOC(=O)C(=C)CO)cc(-c2ccc(-c3ccc(C4CCC(CCCCC)CC4)cc3)c(CC)c2)c1] |
| 1γ-3-38 | 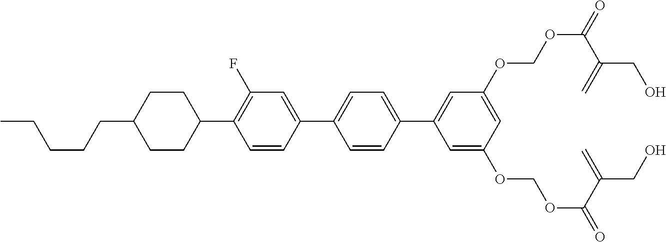 [SMILES: C=C(CO)C(=O)OCOc1cc(OCOC(=O)C(=C)CO)cc(-c2ccc(-c3ccc(C4CCC(CCCCC)CC4)c(F)c3)cc2)c1] |
| 1γ-3-39 | 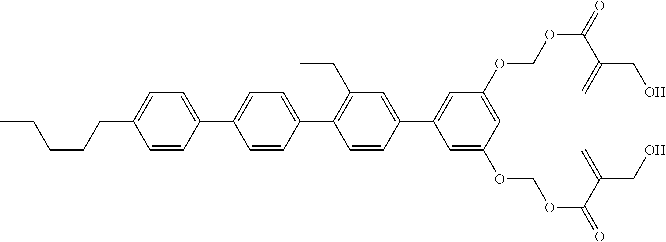 [SMILES: C=C(CO)C(=O)OCOc1cc(OCOC(=O)C(=C)CO)cc(-c2ccc(-c3ccc(-c4ccc(CCCCC)cc4)cc3)c(CC)c2)c1] |
| 1γ-3-40 | 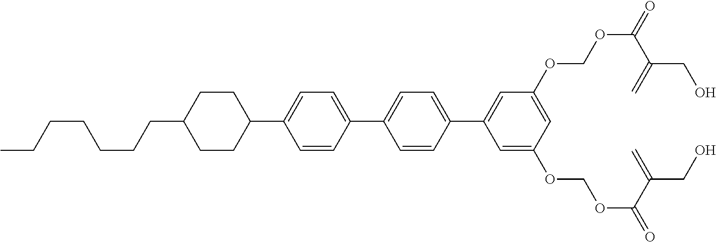 [SMILES: C=C(CO)C(=O)OCOc1cc(OCOC(=O)C(=C)CO)cc(-c2ccc(-c3ccc(C4CCC(CCCCCCC)CC4)cc3)cc2)c1] |
| 1γ-3-41 | 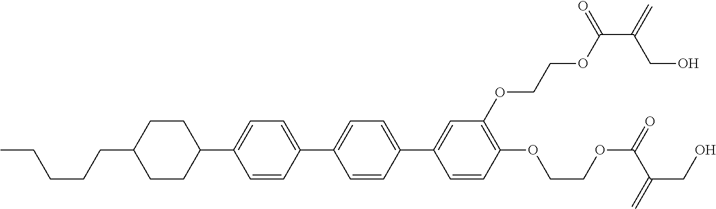 [SMILES: C=C(CO)C(=O)OCCOc1ccc(-c2ccc(-c3ccc(C4CCC(CCCCC)CC4)cc3)cc2)cc1OCCOC(=O)C(=C)CO] |
| 1γ-3-42 | 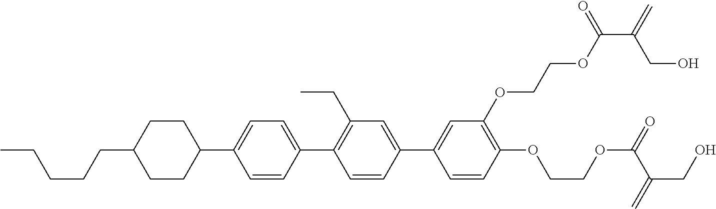 [SMILES: C=C(CO)C(=O)OCCOc1ccc(-c2ccc(-c3ccc(C4CCC(CCCCC)CC4)cc3)c(CC)c2)cc1OCCOC(=O)C(=C)CO] |
| 1γ-3-43 | 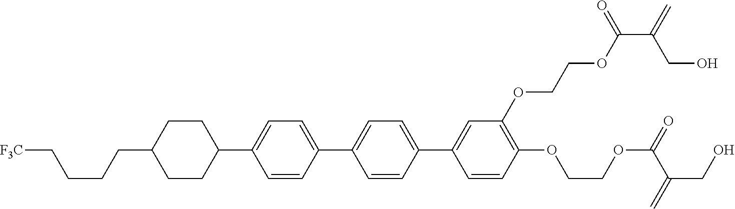 [SMILES: C=C(CO)C(=O)OCCOc1ccc(-c2ccc(-c3ccc(C4CCC(CCCCC(F)(F)F)CC4)cc3)cc2)cc1OCCOC(=O)C(=C)CO] |
| 1γ-3-44 | 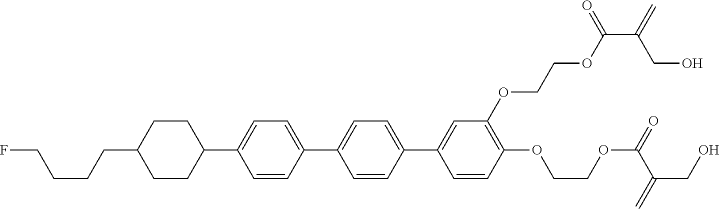 [SMILES: C=C(CO)C(=O)OCCOc1ccc(-c2ccc(-c3ccc(C4CCC(CCCCF)CC4)cc3)cc2)cc1OCCOC(=O)C(=C)CO] |
| 1γ-3-45 | 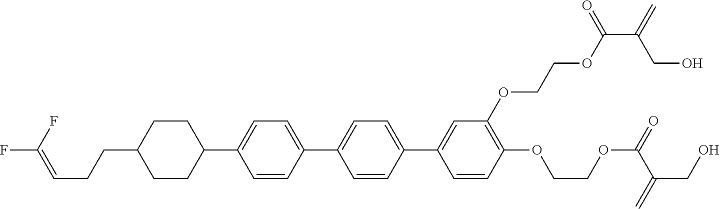 [SMILES: C=C(CO)C(=O)OCCOc1ccc(-c2ccc(-c3ccc(C4CCC(CCC=C(F)F)CC4)cc3)cc2)cc1OCCOC(=O)C(=C)CO] |
| 1γ-3-46 | 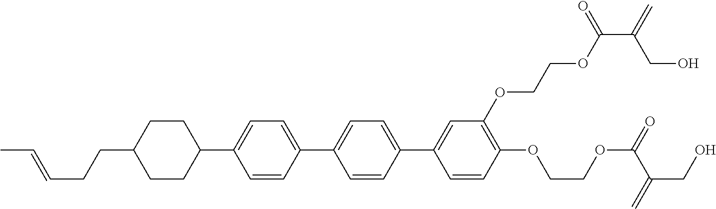 [SMILES: C=C(CO)C(=O)OCCOc1ccc(-c2ccc(-c3ccc(C4CCC(CC/C=C/C)CC4)cc3)cc2)cc1OCCOC(=O)C(=C)CO] |
| 1γ-3-47 | 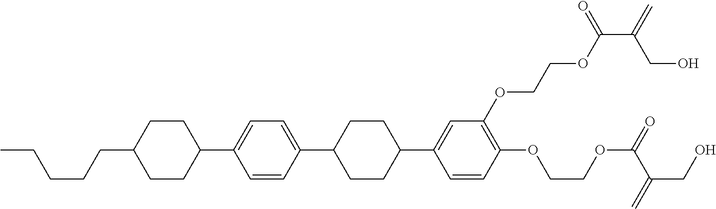 [SMILES: C=C(CO)C(=O)OCCOc1ccc(C2CCC(c3ccc(C4CCC(CCCCC)CC4)cc3)CC2)cc1OCCOC(=O)C(=C)CO] |
| 1γ-3-48 | 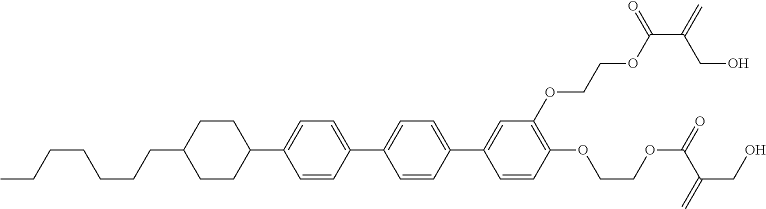 [SMILES: C=C(CO)C(=O)OCCOc1ccc(-c2ccc(-c3ccc(C4CCC(CCCCCCC)CC4)cc3)cc2)cc1OCCOC(=O)C(=C)CO] |
| 1γ-3-49 | 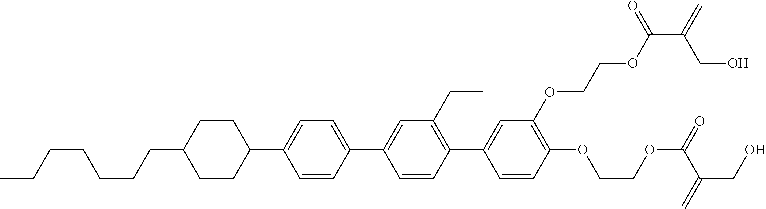 [SMILES: C=C(CO)C(=O)OCCOc1ccc(-c2ccc(-c3ccc(C4CCC(CCCCCCC)CC4)cc3)cc2CC)cc1OCCOC(=O)C(=C)CO] |
| 1γ-3-50 | 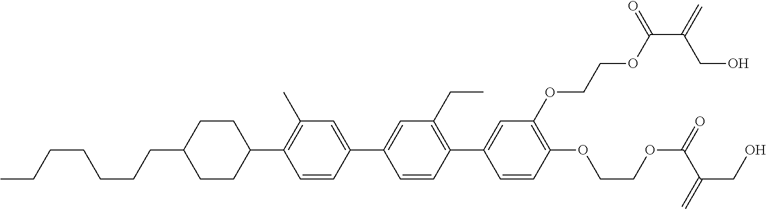 [SMILES: C=C(CO)C(=O)OCCOc1ccc(-c2ccc(-c3ccc(C4CCC(CCCCCCC)CC4)c(C)c3)cc2CC)cc1OCCOC(=O)C(=C)CO] |
| 1γ-3-51 | 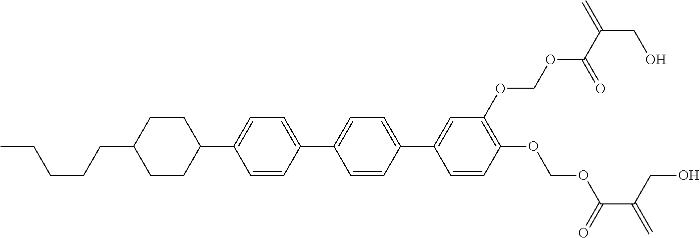 [SMILES: C=C(CO)C(=O)OCOc1ccc(-c2ccc(-c3ccc(C4CCC(CCCCC)CC4)cc3)cc2)cc1OCOC(=O)C(=C)CO] |
| 1γ-3-52 | 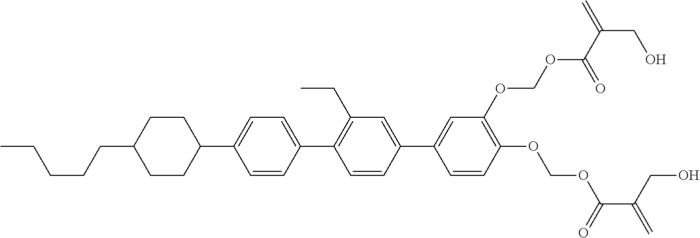 [SMILES: C=C(CO)C(=O)OCOc1ccc(-c2ccc(-c3ccc(C4CCC(CCCCC)CC4)cc3)c(CC)c2)cc1OCOC(=O)C(=C)CO] |
| 1γ-3-53 | 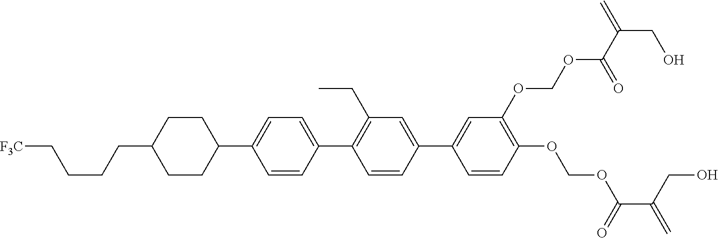 [SMILES: C=C(CO)C(=O)OCOc1ccc(-c2ccc(-c3ccc(C4CCC(CCCCC(F)(F)F)CC4)cc3)c(CC)c2)cc1OCOC(=O)C(=C)CO] |
| 1γ-3-54 | 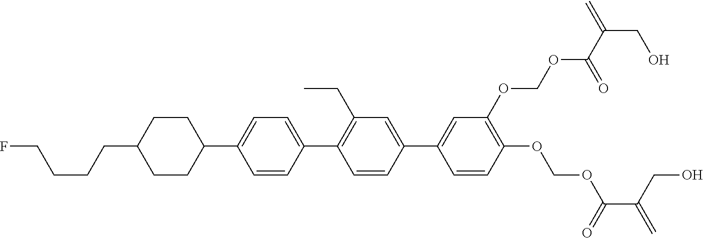 [SMILES: C=C(CO)C(=O)OCOc1ccc(-c2ccc(-c3ccc(C4CCC(CCCCF)CC4)cc3)c(CC)c2)cc1OCOC(=O)C(=C)CO] |
| 1γ-3-55 | 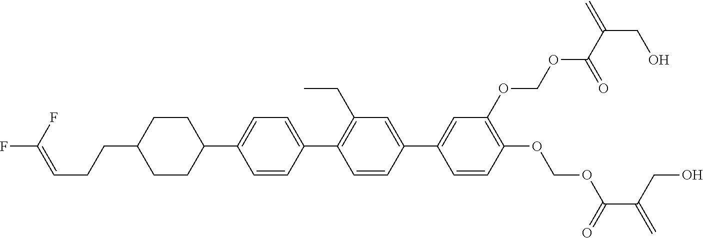 [SMILES: C=C(CO)C(=O)OCOc1ccc(-c2ccc(-c3ccc(C4CCC(CCC=C(F)F)CC4)cc3)c(CC)c2)cc1OCOC(=O)C(=C)CO] |
| 1γ-3-56 | 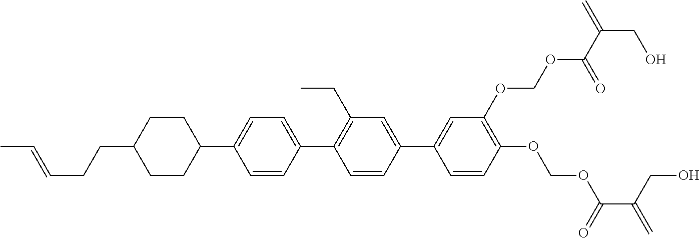 [SMILES: C=C(CO)C(=O)OCOc1ccc(-c2ccc(-c3ccc(C4CCC(CC/C=C/C)CC4)cc3)c(CC)c2)cc1OCOC(=O)C(=C)CO] |
| 1γ-3-57 | 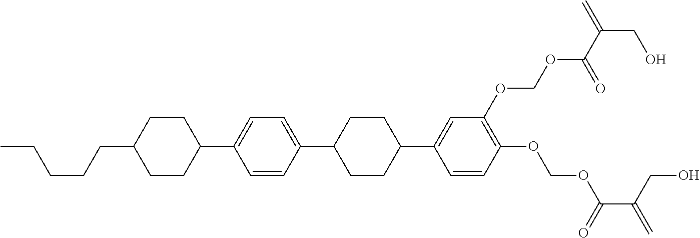 [SMILES: C=C(CO)C(=O)OCOc1ccc(C2CCC(c3ccc(C4CCC(CCCCC)CC4)cc3)CC2)cc1OCOC(=O)C(=C)CO] |
| 1γ-3-58 | 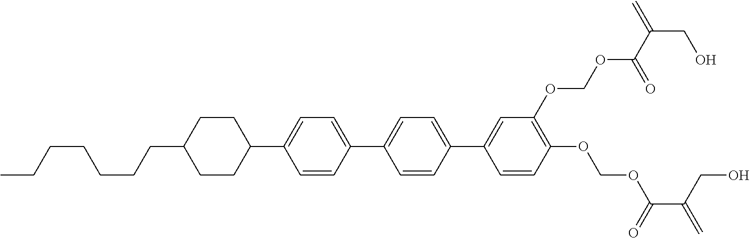 [SMILES: C=C(CO)C(=O)OCOc1ccc(-c2ccc(-c3ccc(C4CCC(CCCCCCC)CC4)cc3)cc2)cc1OCOC(=O)C(=C)CO] |
| 1γ-3-59 | 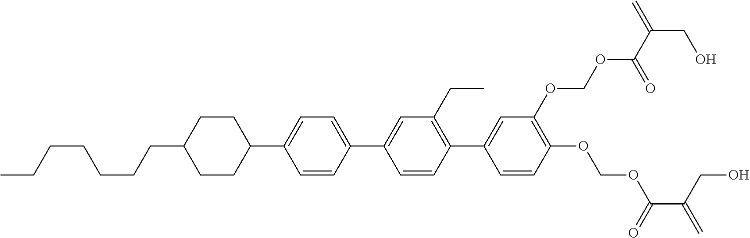 [SMILES: C=C(CO)C(=O)OCOc1ccc(-c2ccc(-c3ccc(C4CCC(CCCCCCC)CC4)cc3)cc2CC)cc1OCOC(=O)C(=C)CO] |
| 1γ-3-60 | 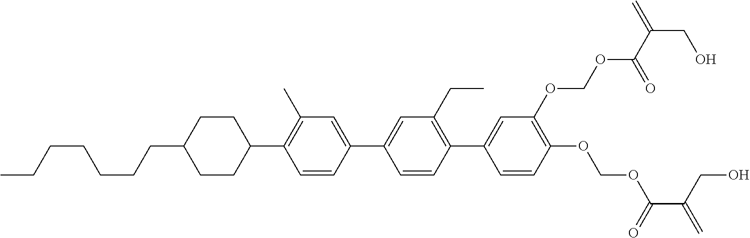 [SMILES: C=C(CO)C(=O)OCOc1ccc(-c2ccc(-c3ccc(C4CCC(CCCCCCC)CC4)c(C)c3)cc2CC)cc1OCOC(=O)C(=C)CO] |
| 1γ-3-61 | 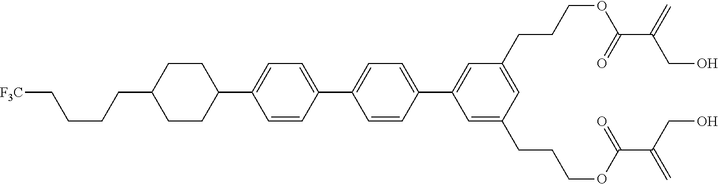 [SMILES: C=C(CO)C(=O)OCCCc1cc(CCCOC(=O)C(=C)CO)cc(-c2ccc(-c3ccc(C4CCC(CCCCC(F)(F)F)CC4)cc3)cc2)c1] |
| 1γ-3-62 | 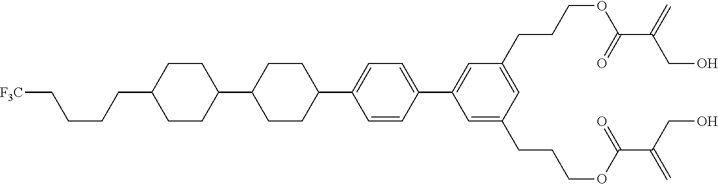 [SMILES: C=C(CO)C(=O)OCCCc1cc(CCCOC(=O)C(=C)CO)cc(-c2ccc(C3CCC(C4CCC(CCCCC(F)(F)F)CC4)CC3)cc2)c1] |
| 1γ-3-63 | 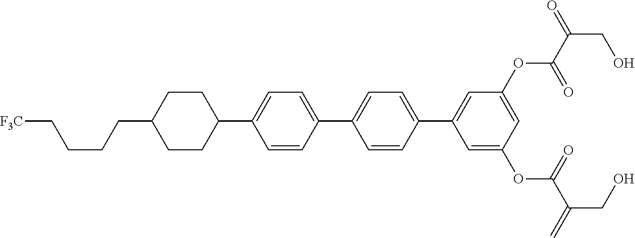 [SMILES: C=C(CO)C(=O)Oc1cc(OC(=O)C(=O)CO)cc(-c2ccc(-c3ccc(C4CCC(CCCCC(F)(F)F)CC4)cc3)cc2)c1] |
| 1γ-3-64 | 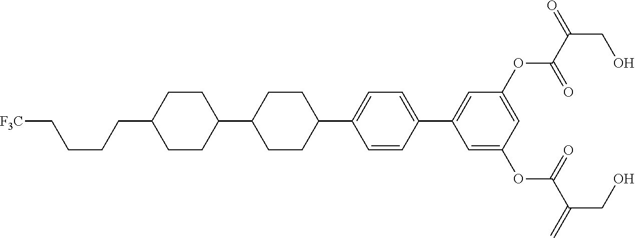 [SMILES: C=C(CO)C(=O)Oc1cc(OC(=O)C(=O)CO)cc(-c2ccc(C3CCC(C4CCC(CCCCC(F)(F)F)CC4)CC3)cc2)c1] |
| 1γ-3-65 | 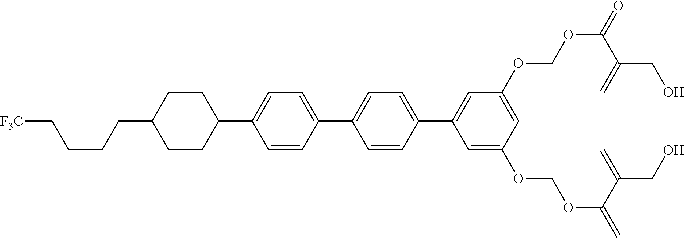 [SMILES: C=C(CO)C(=C)OCOc1cc(OCOC(=O)C(=C)CO)cc(-c2ccc(-c3ccc(C4CCC(CCCCC(F)(F)F)CC4)cc3)cc2)c1] |
| 1γ-3-66 | 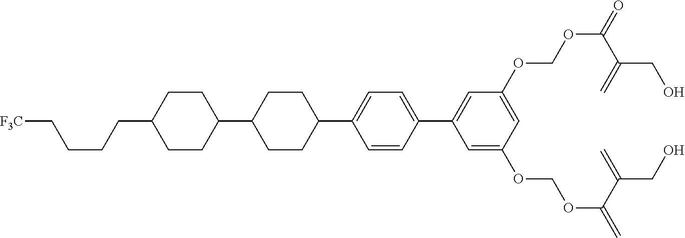 [SMILES: C=C(CO)C(=C)OCOc1cc(OCOC(=O)C(=C)CO)cc(-c2ccc(C3CCC(C4CCC(CCCCC(F)(F)F)CC4)CC3)cc2)c1] |
| 1γ-3-67 | 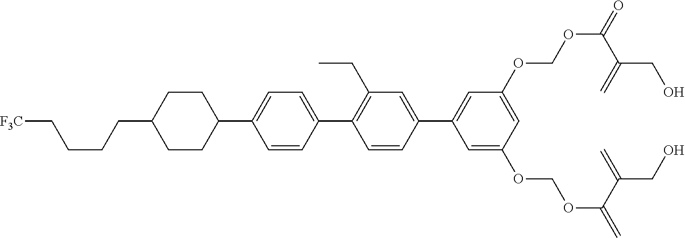 [SMILES: C=C(CO)C(=C)OCOc1cc(OCOC(=O)C(=C)CO)cc(-c2ccc(-c3ccc(C4CCC(CCCCC(F)(F)F)CC4)cc3)c(CC)c2)c1] |
| 1γ-3-68 | 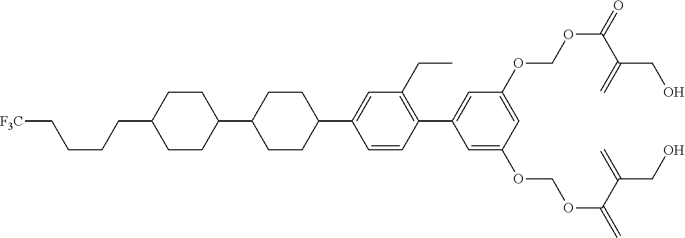 [SMILES: C=C(CO)C(=C)OCOc1cc(OCOC(=O)C(=C)CO)cc(-c2ccc(C3CCC(C4CCC(CCCCC(F)(F)F)CC4)CC3)cc2CC)c1] |
| 1γ-3-69 | 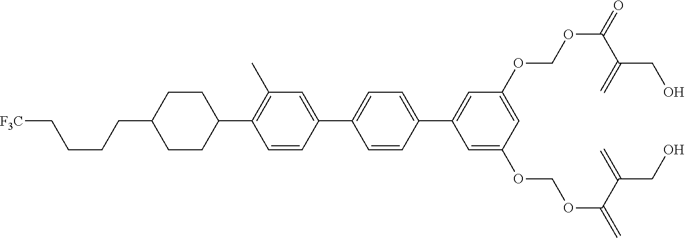 [SMILES: C=C(CO)C(=C)OCOc1cc(OCOC(=O)C(=C)CO)cc(-c2ccc(-c3ccc(C4CCC(CCCCC(F)(F)F)CC4)c(C)c3)cc2)c1] |
| 1γ-3-70 | 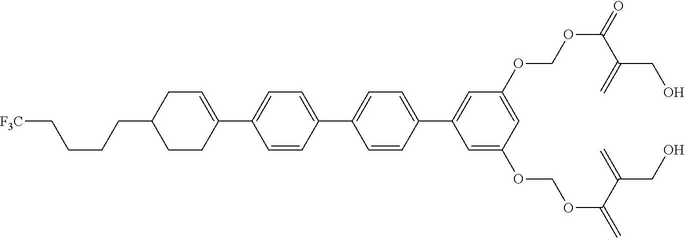 [SMILES: C=C(CO)C(=C)OCOc1cc(OCOC(=O)C(=C)CO)cc(-c2ccc(-c3ccc(C4=CCC(CCCCC(F)(F)F)CC4)cc3)cc2)c1] |
| 1γ-3-71 | 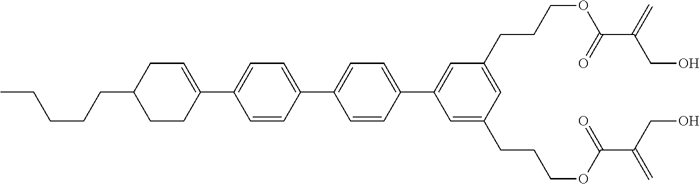 [SMILES: C=C(CO)C(=O)OCCCc1cc(CCCOC(=O)C(=C)CO)cc(-c2ccc(-c3ccc(C4=CCC(CCCCC)CC4)cc3)cc2)c1] |
| 1γ-3-72 | 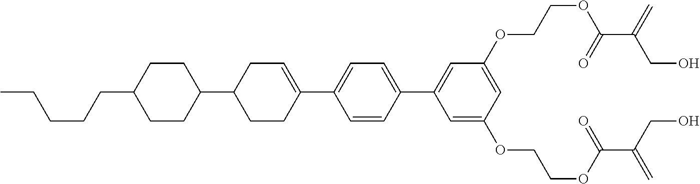 [SMILES: C=C(CO)C(=O)OCCOc1cc(OCCOC(=O)C(=C)CO)cc(-c2ccc(C3=CCC(C4CCC(CCCCC)CC4)CC3)cc2)c1] |
| 1γ-3-73 | 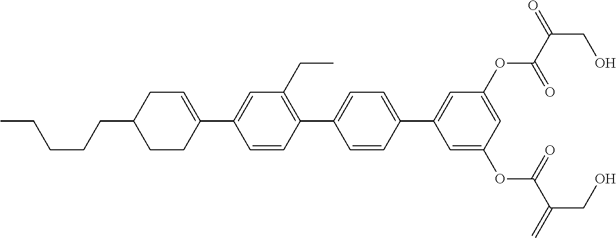 [SMILES: C=C(CO)C(=O)Oc1cc(OC(=O)C(=O)CO)cc(-c2ccc(-c3ccc(C4=CCC(CCCCC)CC4)cc3CC)cc2)c1] |
| 1γ-3-74 | 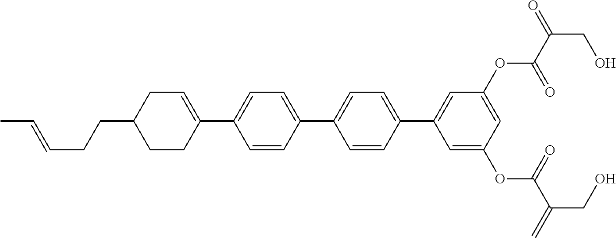 [SMILES: C=C(CO)C(=O)Oc1cc(OC(=O)C(=O)CO)cc(-c2ccc(-c3ccc(C4=CCC(CC/C=C/C)CC4)cc3)cc2)c1] |
| 1γ-3-75 | 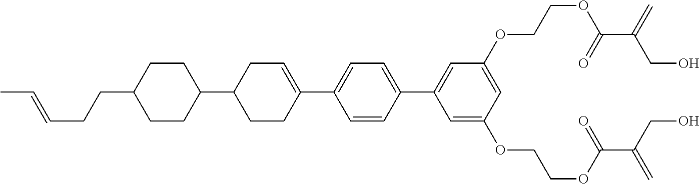 [SMILES: C=C(CO)C(=O)OCCOc1cc(OCCOC(=O)C(=C)CO)cc(-c2ccc(C3=CCC(C4CCC(CC/C=C/C)CC4)CC3)cc2)c1] |
| 1γ-3-76 | 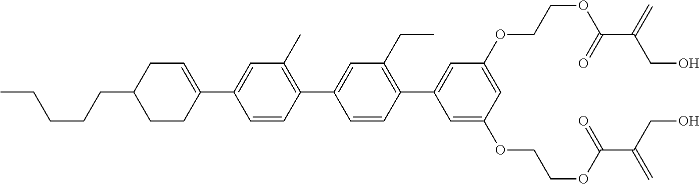 [SMILES: C=C(CO)C(=O)OCCOc1cc(OCCOC(=O)C(=C)CO)cc(-c2ccc(-c3ccc(C4=CCC(CCCCC)CC4)cc3C)cc2CC)c1] |
| 1γ-3-77 | 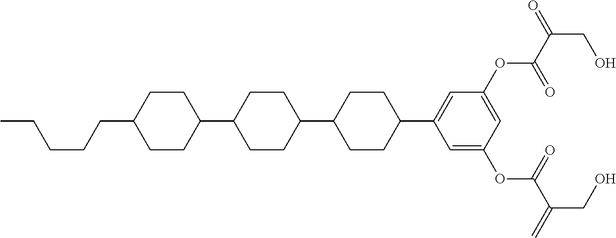 [SMILES: C=C(CO)C(=O)Oc1cc(OC(=O)C(=O)CO)cc(C2CCC(C3CCC(C4CCC(CCCCC)CC4)CC3)CC2)c1] |
| 1γ-3-78 | 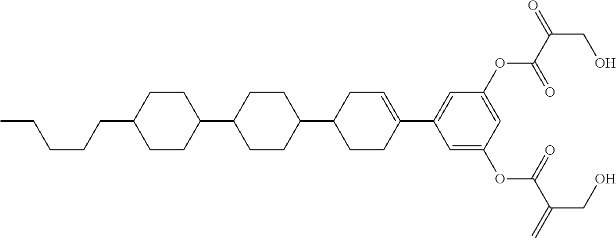 [SMILES: C=C(CO)C(=O)Oc1cc(OC(=O)C(=O)CO)cc(C2=CCC(C3CCC(C4CCC(CCCCC)CC4)CC3)CC2)c1] |
| 1γ-3-79 | 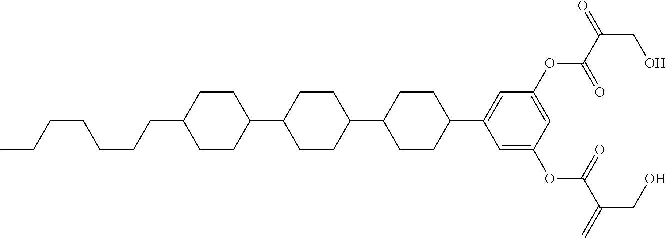 [SMILES: C=C(CO)C(=O)Oc1cc(OC(=O)C(=O)CO)cc(C2CCC(C3CCC(C4CCC(CCCCCCC)CC4)CC3)CC2)c1] |
| 1γ-3-80 | 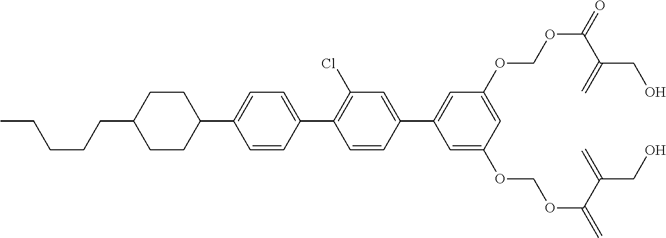 [SMILES: C=C(CO)C(=C)OCOc1cc(OCOC(=O)C(=C)CO)cc(-c2ccc(-c3ccc(C4CCC(CCCCC)CC4)cc3)c(Cl)c2)c1] |
| 1γ-3-81 | 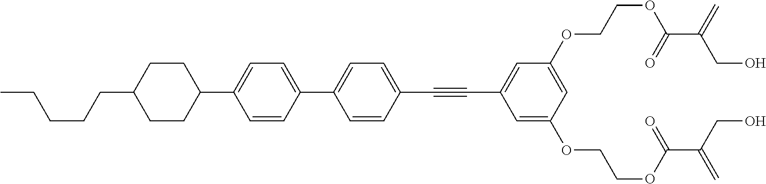 [SMILES: C=C(CO)C(=O)OCCOc1cc(C#Cc2ccc(-c3ccc(C4CCC(CCCCC)CC4)cc3)cc2)cc(OCCOC(=O)C(=C)CO)c1] |
| 1γ-3-82 | 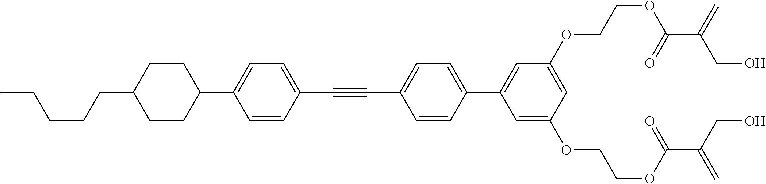 [SMILES: C=C(CO)C(=O)OCCOc1cc(OCCOC(=O)C(=C)CO)cc(-c2ccc(C#Cc3ccc(C4CCC(CCCCC)CC4)cc3)cc2)c1] |
| 1γ-3-83 | 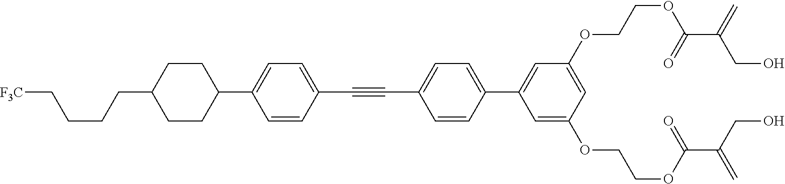 [SMILES: C=C(CO)C(=O)OCCOc1cc(OCCOC(=O)C(=C)CO)cc(-c2ccc(C#Cc3ccc(C4CCC(CCCCC(F)(F)F)CC4)cc3)cc2)c1] |
| 1γ-3-84 | 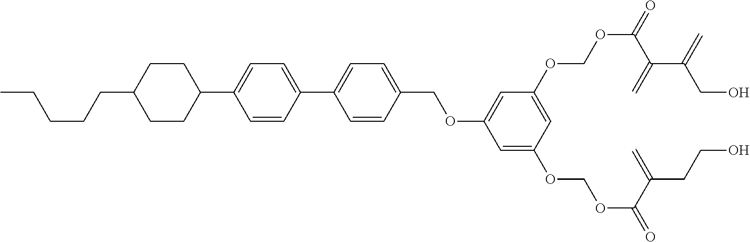 [SMILES: C=C(CO)C(=C)C(=O)OCOc1cc(OCOC(=O)C(=C)CCO)cc(OCc2ccc(-c3ccc(C4CCC(CCCCC)CC4)cc3)cc2)c1] |
| 1γ-3-85 | 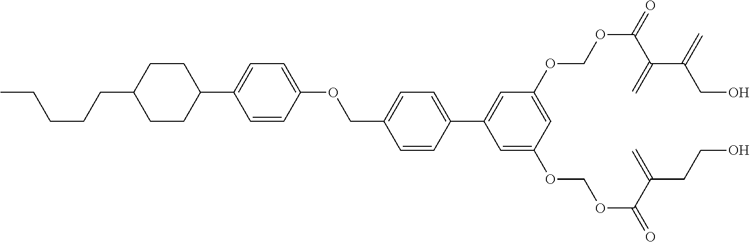 [SMILES: C=C(CO)C(=C)C(=O)OCOc1cc(OCOC(=O)C(=C)CCO)cc(-c2ccc(COc3ccc(C4CCC(CCCCC)CC4)cc3)cc2)c1] |
| 1γ-3-86 | 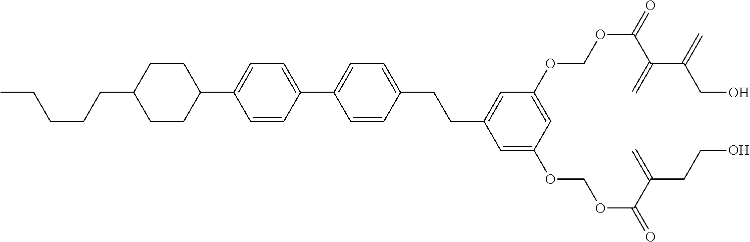 [SMILES: C=C(CO)C(=C)C(=O)OCOc1cc(CCc2ccc(-c3ccc(C4CCC(CCCCC)CC4)cc3)cc2)cc(OCOC(=O)C(=C)CCO)c1] |
| 1γ-3-87 | 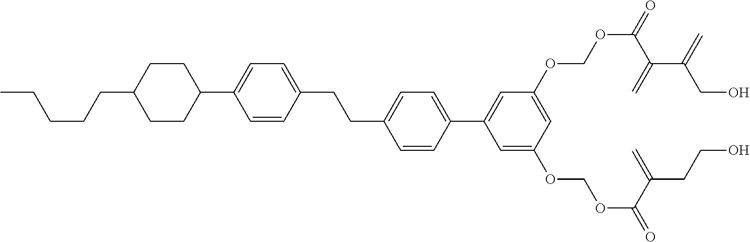 [SMILES: C=C(CO)C(=C)C(=O)OCOc1cc(OCOC(=O)C(=C)CCO)cc(-c2ccc(CCc3ccc(C4CCC(CCCCC)CC4)cc3)cc2)c1] |
| 1γ-3-88 | 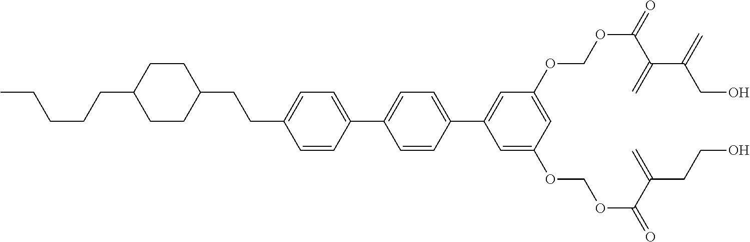 [SMILES: C=C(CO)C(=C)C(=O)OCOc1cc(OCOC(=O)C(=C)CCO)cc(-c2ccc(-c3ccc(CCC4CCC(CCCCC)CC4)cc3)cc2)c1] |
| 1γ-3-89 | 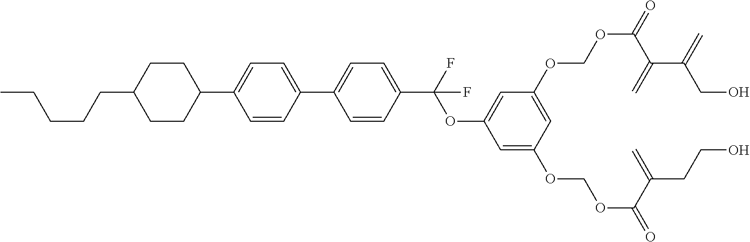 [SMILES: C=C(CO)C(=C)C(=O)OCOc1cc(OCOC(=O)C(=C)CCO)cc(OC(F)(F)c2ccc(-c3ccc(C4CCC(CCCCC)CC4)cc3)cc2)c1] |
| 1γ-3-90 | 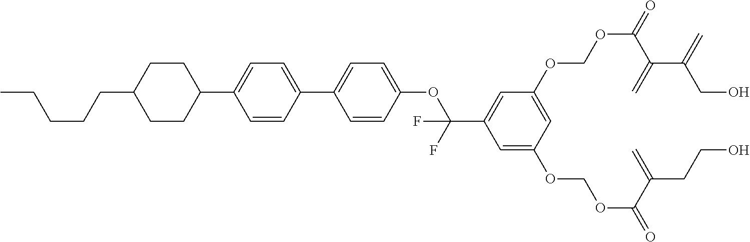 [SMILES: C=C(CO)C(=C)C(=O)OCOc1cc(OCOC(=O)C(=C)CCO)cc(C(F)(F)Oc2ccc(-c3ccc(C4CCC(CCCCC)CC4)cc3)cc2)c1] |
| 1γ-3-91 | 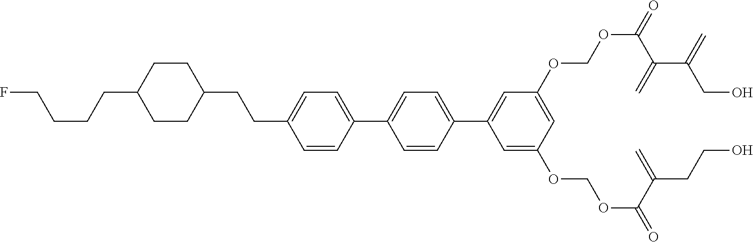 [SMILES: C=C(CO)C(=C)C(=O)OCOc1cc(OCOC(=O)C(=C)CCO)cc(-c2ccc(-c3ccc(CCC4CCC(CCCCF)CC4)cc3)cc2)c1] |
| 1γ-3-92 | 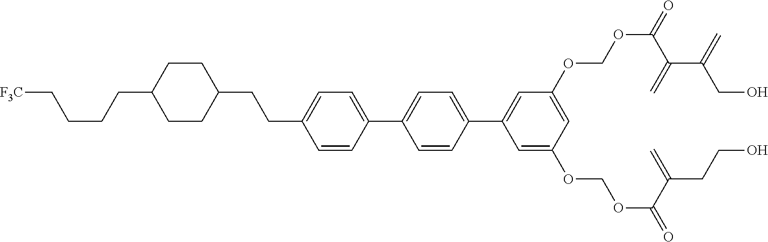 [SMILES: C=C(CO)C(=C)C(=O)OCOc1cc(OCOC(=O)C(=C)CCO)cc(-c2ccc(-c3ccc(CCC4CCC(CCCCC(F)(F)F)CC4)cc3)cc2)c1] |
| 1γ-3-93 | 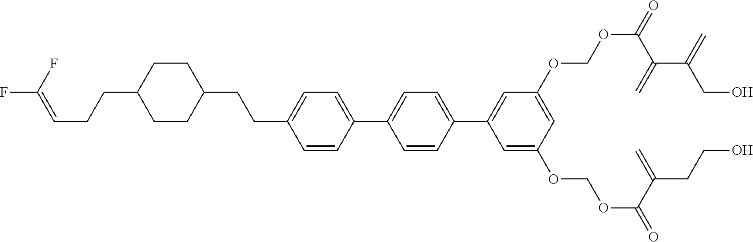 [SMILES: C=C(CO)C(=C)C(=O)OCOc1cc(OCOC(=O)C(=C)CCO)cc(-c2ccc(-c3ccc(CCC4CCC(CCC=C(F)F)CC4)cc3)cc2)c1] |
| 1γ-3-94 | 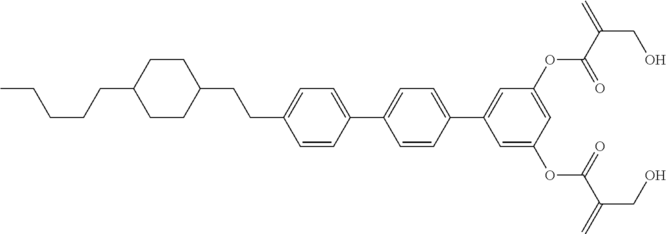 [SMILES: C=C(CO)C(=O)Oc1cc(OC(=O)C(=C)CO)cc(-c2ccc(-c3ccc(CCC4CCC(CCCCC)CC4)cc3)cc2)c1] |
| 1γ-3-95 | 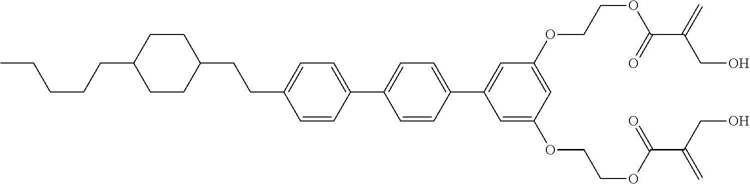 [SMILES: C=C(CO)C(=O)OCCOc1cc(OCCOC(=O)C(=C)CO)cc(-c2ccc(-c3ccc(CCC4CCC(CCCCC)CC4)cc3)cc2)c1] |
| 1γ-3-96 | 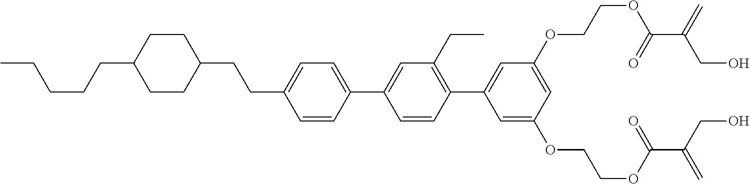 [SMILES: C=C(CO)C(=O)OCCOc1cc(OCCOC(=O)C(=C)CO)cc(-c2ccc(-c3ccc(CCC4CCC(CCCCC)CC4)cc3)cc2CC)c1] |
| 1γ-3-97 | 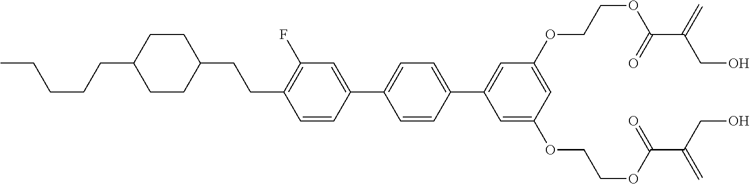 [SMILES: C=C(CO)C(=O)OCCOc1cc(OCCOC(=O)C(=C)CO)cc(-c2ccc(-c3ccc(CCC4CCC(CCCCC)CC4)c(F)c3)cc2)c1] |
| 1γ-3-98 | 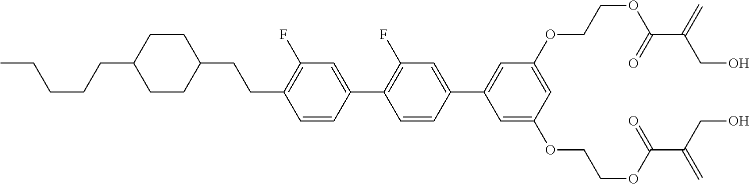 [SMILES: C=C(CO)C(=O)OCCOc1cc(OCCOC(=O)C(=C)CO)cc(-c2ccc(-c3ccc(CCC4CCC(CCCCC)CC4)c(F)c3)c(F)c2)c1] |
| 1γ-3-99 | 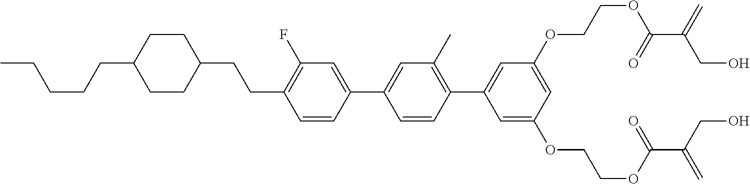 [SMILES: C=C(CO)C(=O)OCCOc1cc(OCCOC(=O)C(=C)CO)cc(-c2ccc(-c3ccc(CCC4CCC(CCCCC)CC4)c(F)c3)cc2C)c1] |
| 1γ-3-100 | 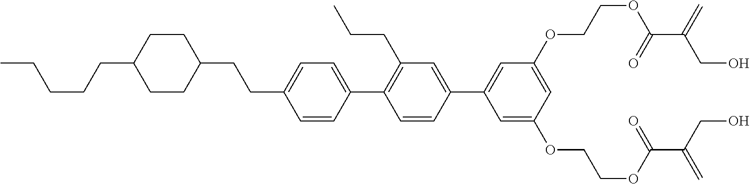 [SMILES: C=C(CO)C(=O)OCCOc1cc(OCCOC(=O)C(=C)CO)cc(-c2ccc(-c3ccc(CCC4CCC(CCCCC)CC4)cc3)c(CCC)c2)c1] |
| 1γ-4-1 | 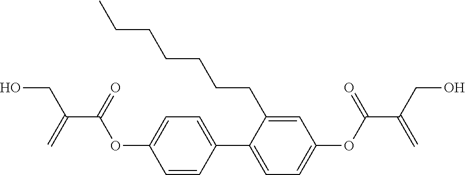 [SMILES: C=C(CO)C(=O)Oc1ccc(-c2ccc(OC(=O)C(=C)CO)cc2CCCCCCC)cc1] |
| 1γ-4-2 | 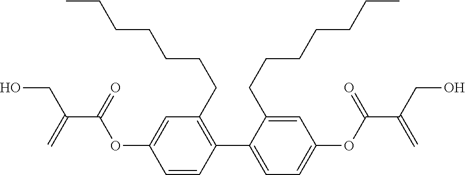 [SMILES: C=C(CO)C(=O)Oc1ccc(-c2ccc(OC(=O)C(=C)CO)cc2CCCCCCC)c(CCCCCCC)c1] |
| 1γ-4-3 | 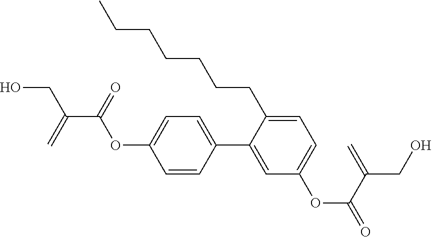 [SMILES: C=C(CO)C(=O)Oc1ccc(-c2cc(OC(=O)C(=C)CO)ccc2CCCCCCC)cc1] |
| 1γ-4-4 | 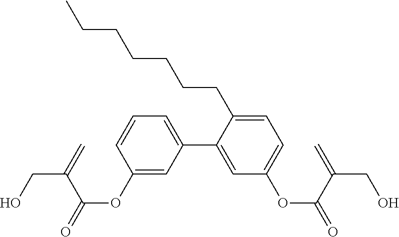 [SMILES: C=C(CO)C(=O)Oc1cccc(-c2cc(OC(=O)C(=C)CO)ccc2CCCCCCC)c1] |
| 1γ-4-5 | 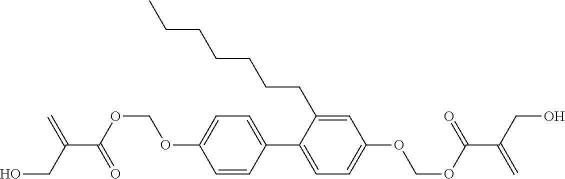 [SMILES: C=C(CO)C(=O)OCOc1ccc(-c2ccc(OCOC(=O)C(=C)CO)cc2CCCCCCC)cc1] |
| 1γ-4-6 | 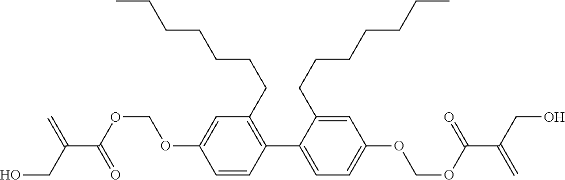 [SMILES: C=C(CO)C(=O)OCOc1ccc(-c2ccc(OCOC(=O)C(=C)CO)cc2CCCCCCC)c(CCCCCCC)c1] |
| 1γ-4-7 | 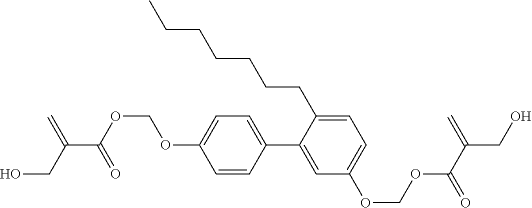 [SMILES: C=C(CO)C(=O)OCOc1ccc(-c2cc(OCOC(=O)C(=C)CO)ccc2CCCCCCC)cc1] |
| 1γ-4-8 | 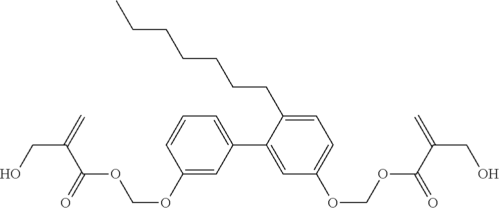 [SMILES: C=C(CO)C(=O)OCOc1cccc(-c2cc(OCOC(=O)C(=C)CO)ccc2CCCCCCC)c1] |
| 1γ-4-9 | 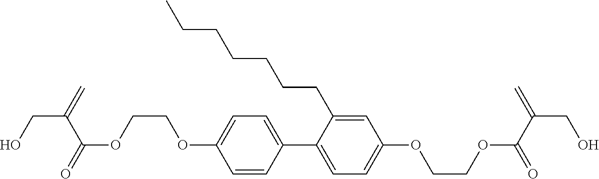 [SMILES: C=C(CO)C(=O)OCCOc1ccc(-c2ccc(OCCOC(=O)C(=C)CO)cc2CCCCCCC)cc1] |
| 1γ-4-10 | 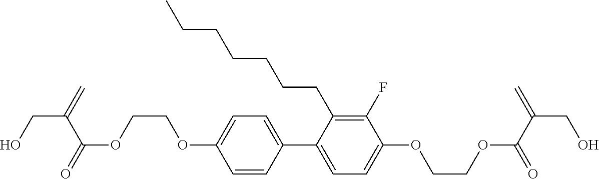 [SMILES: C=C(CO)C(=O)OCCOc1ccc(-c2ccc(OCCOC(=O)C(=C)CO)c(F)c2CCCCCCC)cc1] |
| 1γ-4-11 | 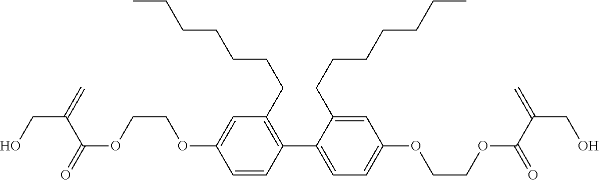 [SMILES: C=C(CO)C(=O)OCCOc1ccc(-c2ccc(OCCOC(=O)C(=C)CO)cc2CCCCCCC)c(CCCCCCC)c1] |
| 1γ-4-12 | 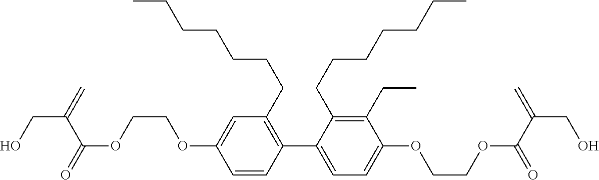 [SMILES: C=C(CO)C(=O)OCCOc1ccc(-c2ccc(OCCOC(=O)C(=C)CO)c(CC)c2CCCCCCC)c(CCCCCCC)c1] |
| 1γ-4-13 | 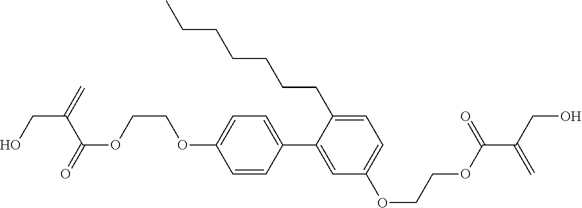 [SMILES: C=C(CO)C(=O)OCCOc1ccc(-c2cc(OCCOC(=O)C(=C)CO)ccc2CCCCCCC)cc1] |
| 1γ-4-14 | 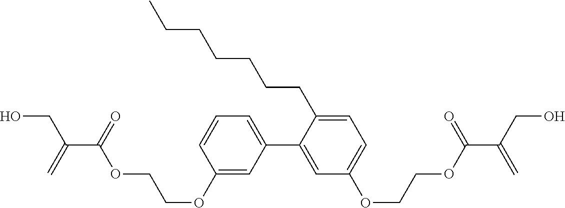 [SMILES: C=C(CO)C(=O)OCCOc1cccc(-c2cc(OCCOC(=O)C(=C)CO)ccc2CCCCCCC)c1] |
| 1γ-4-15 | 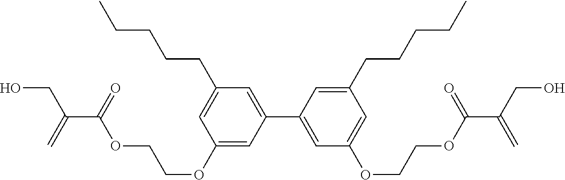 [SMILES: C=C(CO)C(=O)OCCOc1cc(CCCCC)cc(-c2cc(CCCCC)cc(OCCOC(=O)C(=C)CO)c2)c1] |
| 1γ-4-16 | 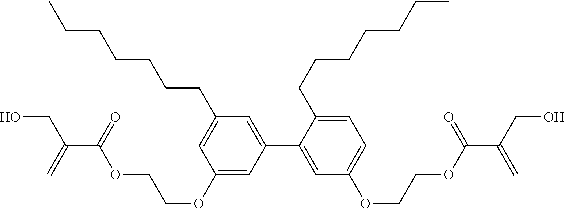 [SMILES: C=C(CO)C(=O)OCCOc1cc(CCCCCCC)cc(-c2cc(OCCOC(=O)C(=C)CO)ccc2CCCCCCC)c1] |
| 1γ-4-17 | 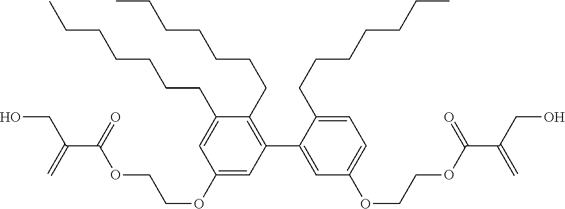 [SMILES: C=C(CO)C(=O)OCCOc1ccc(CCCCCCC)c(-c2cc(OCCOC(=O)C(=C)CO)cc(CCCCCCC)c2CCCCCCC)c1] |
| 1γ-4-18 | 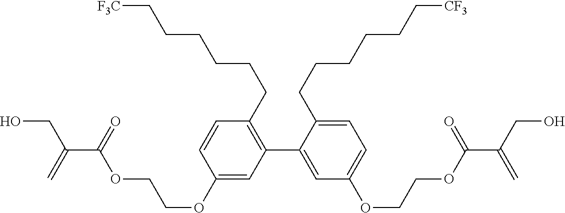 [SMILES: C=C(CO)C(=O)OCCOc1ccc(CCCCCCC(F)(F)F)c(-c2cc(OCCOC(=O)C(=C)CO)ccc2CCCCCCC(F)(F)F)c1] |
| 1γ-4-19 | 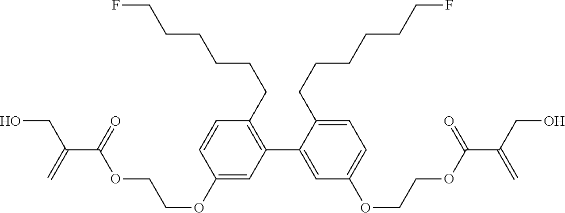 [SMILES: C=C(CO)C(=O)OCCOc1ccc(CCCCCCF)c(-c2cc(OCCOC(=O)C(=C)CO)ccc2CCCCCCF)c1] |
| 1γ-4-20 | 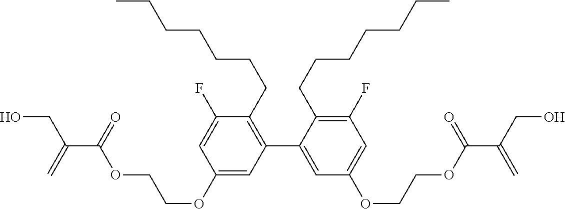 [SMILES: C=C(CO)C(=O)OCCOc1cc(F)c(CCCCCCC)c(-c2cc(OCCOC(=O)C(=C)CO)cc(F)c2CCCCCCC)c1] |
| 1γ-4-21 | 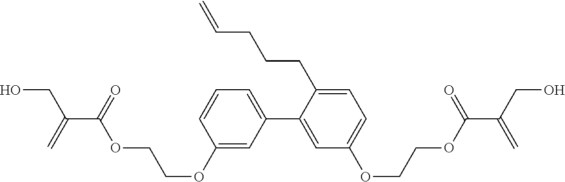 [SMILES: C=CCCCc1ccc(OCCOC(=O)C(=C)CO)cc1-c1cccc(OCCOC(=O)C(=C)CO)c1] |
| 1γ-4-22 | 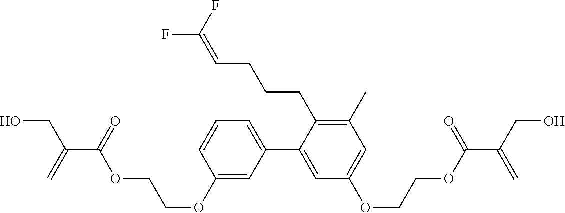 [SMILES: C=C(CO)C(=O)OCCOc1cccc(-c2cc(OCCOC(=O)C(=C)CO)cc(C)c2CCCC=C(F)F)c1] |
| 1γ-4-23 | 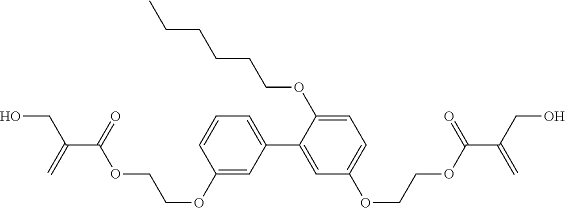 [SMILES: C=C(CO)C(=O)OCCOc1cccc(-c2cc(OCCOC(=O)C(=C)CO)ccc2OCCCCCC)c1] |
| 1γ-4-24 | 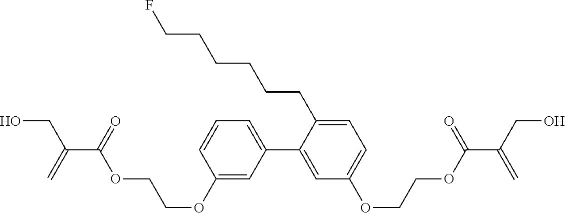 [SMILES: C=C(CO)C(=O)OCCOc1cccc(-c2cc(OCCOC(=O)C(=C)CO)ccc2CCCCCCF)c1] |
| 1γ-4-25 | 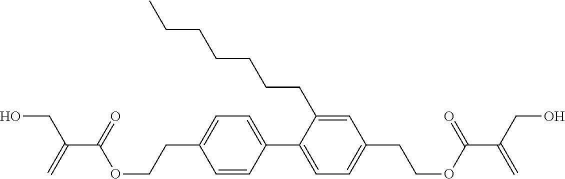 [SMILES: C=C(CO)C(=O)OCCc1ccc(-c2ccc(CCOC(=O)C(=C)CO)cc2CCCCCCC)cc1] |
| 1γ-4-26 | 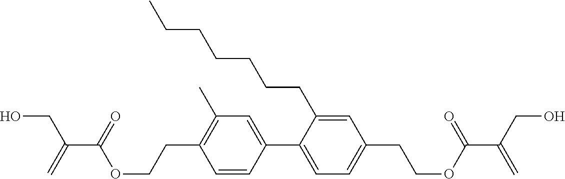 [SMILES: C=C(CO)C(=O)OCCc1ccc(-c2ccc(CCOC(=O)C(=C)CO)c(C)c2)c(CCCCCCC)c1] |
| 1γ-4-27 | 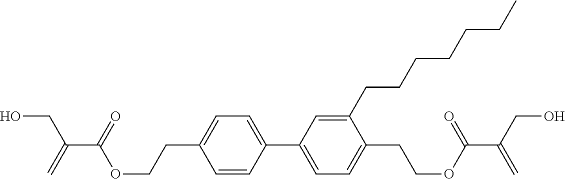 [SMILES: C=C(CO)C(=O)OCCc1ccc(-c2ccc(CCOC(=O)C(=C)CO)c(CCCCCCC)c2)cc1] |
| 1γ-4-28 | 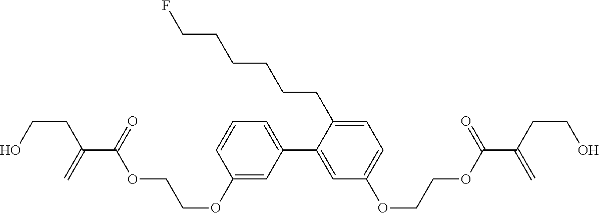 [SMILES: C=C(CCO)C(=O)OCCOc1cccc(-c2cc(OCCOC(=O)C(=C)CCO)ccc2CCCCCCF)c1] |
| 1γ-4-29 | 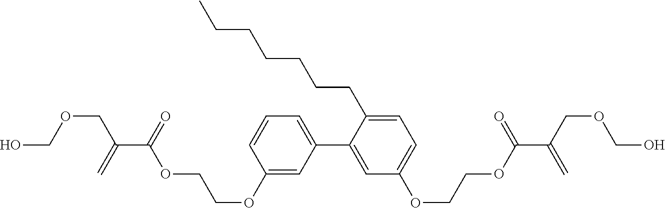 [SMILES: C=C(COCO)C(=O)OCCOc1cccc(-c2cc(OCCOC(=O)C(=C)COCO)ccc2CCCCCCC)c1] |
| 1γ-4-30 | 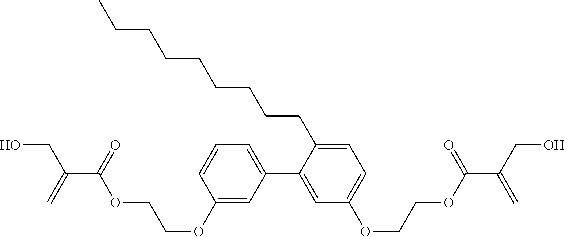 [SMILES: C=C(CO)C(=O)OCCOc1cccc(-c2cc(OCCOC(=O)C(=C)CO)ccc2CCCCCCCCC)c1] |
| 1γ-4-31 | 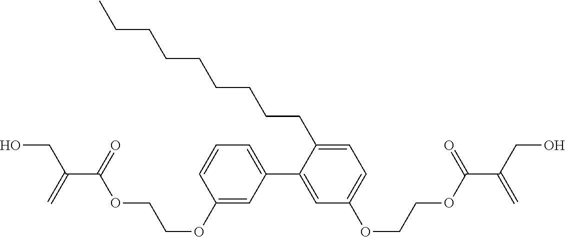 [SMILES: C=C(CO)C(=O)OCCOc1cccc(-c2cc(OCCOC(=O)C(=C)CO)ccc2CCCCCCCCC)c1] |
| 1γ-4-32 | 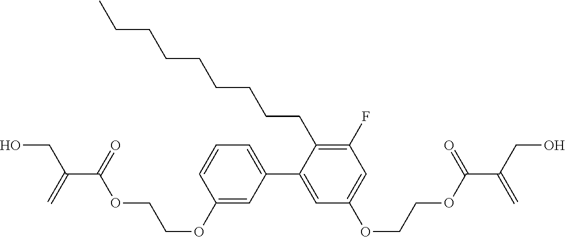 [SMILES: C=C(CO)C(=O)OCCOc1cccc(-c2cc(OCCOC(=O)C(=C)CO)cc(F)c2CCCCCCCCC)c1] |
| 1γ-4-33 | 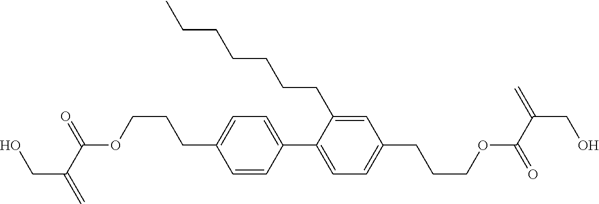 [SMILES: C=C(CO)C(=O)OCCCc1ccc(-c2ccc(CCCOC(=O)C(=C)CO)cc2CCCCCCC)cc1] |
| 1γ-4-34 | 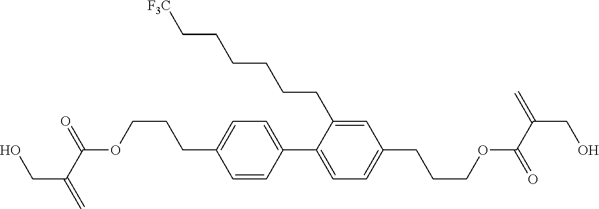 [SMILES: C=C(CO)C(=O)OCCCc1ccc(-c2ccc(CCCOC(=O)C(=C)CO)cc2CCCCCCC(F)(F)F)cc1] |
| 1γ-4-35 | 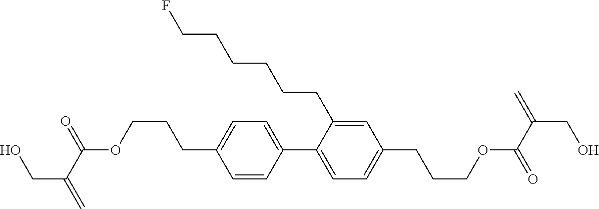 [SMILES: C=C(CO)C(=O)OCCCc1ccc(-c2ccc(CCCOC(=O)C(=C)CO)cc2CCCCCCF)cc1] |
| 1γ-4-36 | 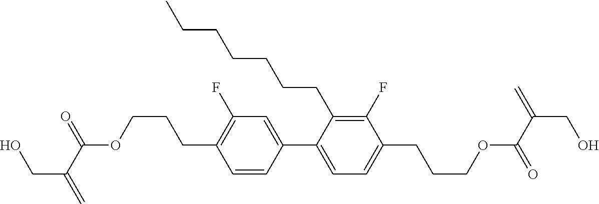 [SMILES: C=C(CO)C(=O)OCCCc1ccc(-c2ccc(CCCOC(=O)C(=C)CO)c(F)c2CCCCCCC)cc1F] |
| 1γ-4-37 | 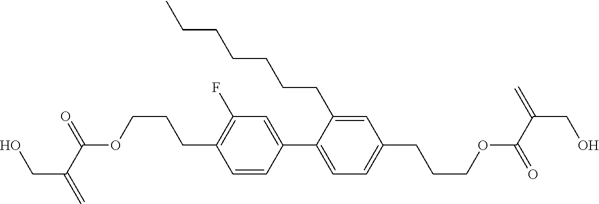 [SMILES: C=C(CO)C(=O)OCCCc1ccc(-c2ccc(CCCOC(=O)C(=C)CO)c(F)c2)c(CCCCCCC)c1] |
| 1γ-4-38 | 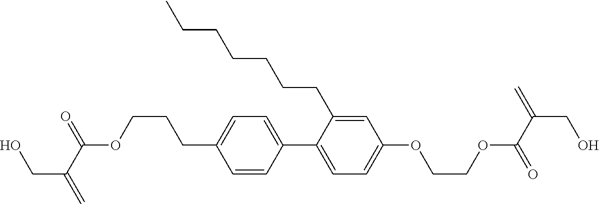 [SMILES: C=C(CO)C(=O)OCCCc1ccc(-c2ccc(OCCOC(=O)C(=C)CO)cc2CCCCCCC)cc1] |
| 1γ-4-39 | 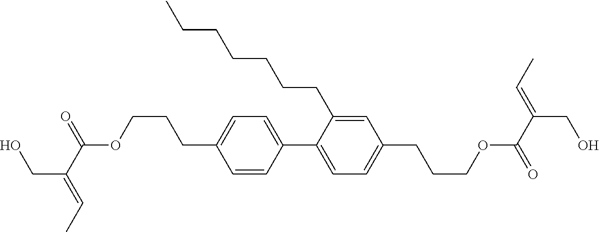 [SMILES: C/C=C(\CO)C(=O)OCCCc1ccc(-c2ccc(CCCOC(=O)/C(=C/C)CO)cc2CCCCCCC)cc1] |
| 1γ-4-40 | 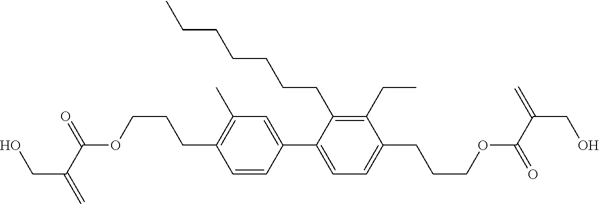 [SMILES: C=C(CO)C(=O)OCCCc1ccc(-c2ccc(CCCOC(=O)C(=C)CO)c(CC)c2CCCCCCC)cc1C] |
| 1γ-4-41 | 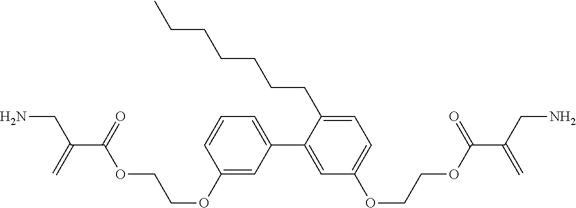 [SMILES: C=C(CN)C(=O)OCCOc1cccc(-c2cc(OCCOC(=O)C(=C)CN)ccc2CCCCCCC)c1] |
| 1γ-4-42 | 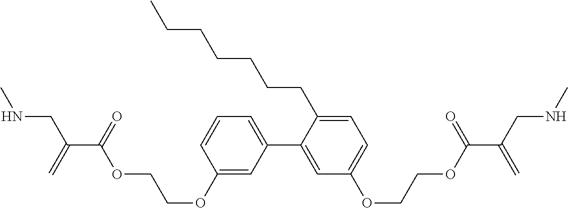 |
| 1γ-4-43 | 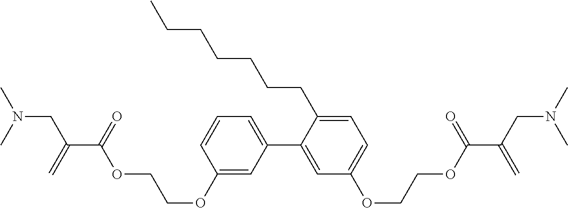 |
| 1γ-4-44 | 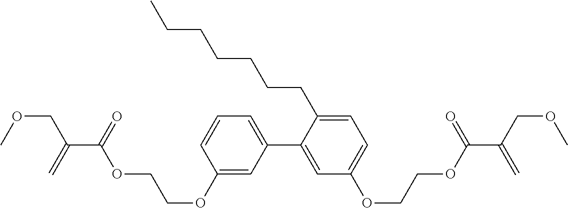 |
| 1γ-4-45 | 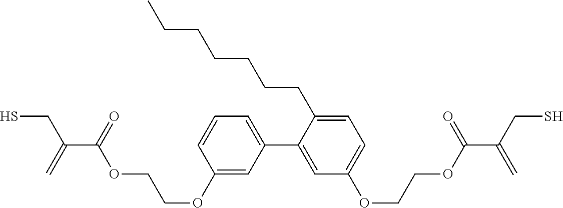 [SMILES: C=C(CS)C(=O)OCCOc1cccc(-c2cc(OCCOC(=O)C(=C)CS)ccc2CCCCCCC)c1] |
| 1γ-4-46 | 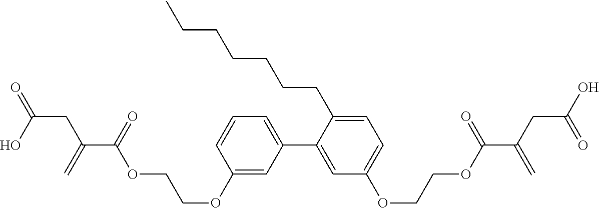 [SMILES: C=C(CC(=O)O)C(=O)OCCOc1cccc(-c2cc(OCCOC(=O)C(=C)CC(=O)O)ccc2CCCCCCC)c1] |
| 1γ-4-47 | 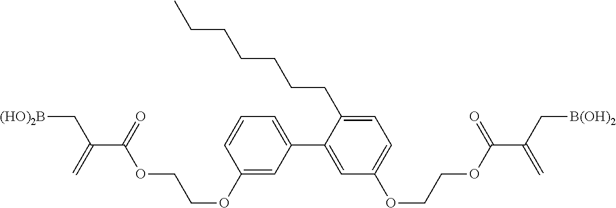 [SMILES: C=C(CB(O)O)C(=O)OCCOc1cccc(-c2cc(OCCOC(=O)C(=C)CB(O)O)ccc2CCCCCCC)c1] |
| 1γ-4-48 | 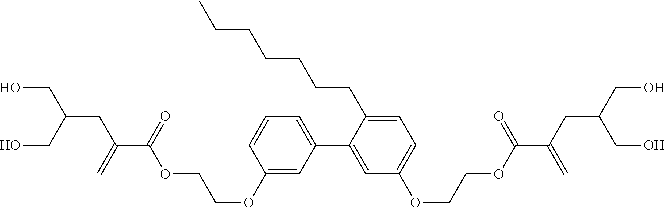 [SMILES: C=C(CC(CO)CO)C(=O)OCCOc1cccc(-c2cc(OCCOC(=O)C(=C)CC(CO)CO)ccc2CCCCCCC)c1] |
| 1γ-4-49 | 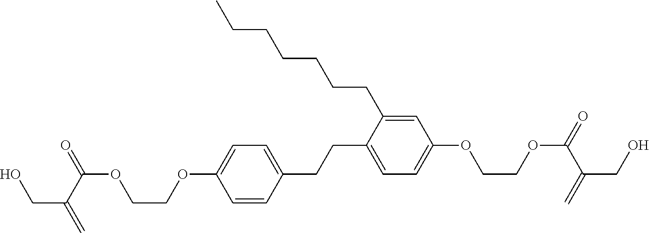 [SMILES: C=C(CO)C(=O)OCCOc1ccc(CCc2ccc(OCCOC(=O)C(=C)CO)cc2CCCCCCC)cc1] |
| 1γ-4-50 | 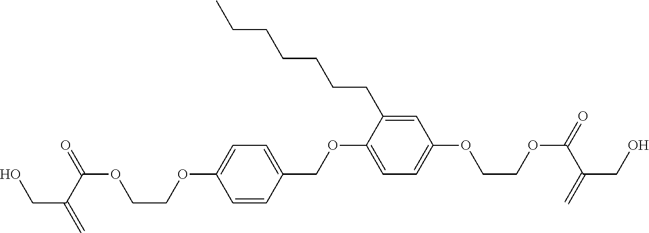 [SMILES: C=C(CO)C(=O)OCCOc1ccc(COc2ccc(OCCOC(=O)C(=C)CO)cc2CCCCCCC)cc1] |
| 1γ-4-51 | 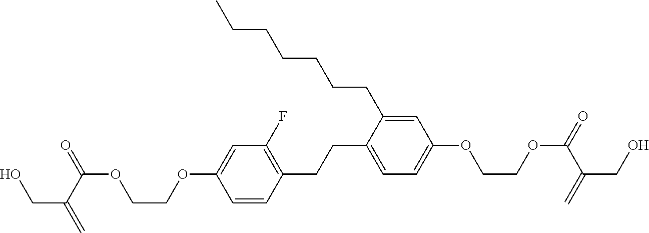 [SMILES: C=C(CO)C(=O)OCCOc1ccc(CCc2ccc(OCCOC(=O)C(=C)CO)cc2CCCCCCC)c(F)c1] |
| 1γ-4-52 | 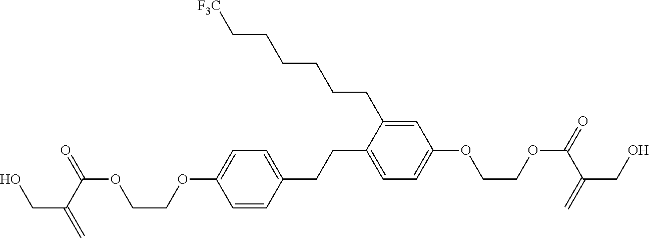 [SMILES: C=C(CO)C(=O)OCCOc1ccc(CCc2ccc(OCCOC(=O)C(=C)CO)cc2CCCCCCC(F)(F)F)cc1] |
| 1γ-4-53 | 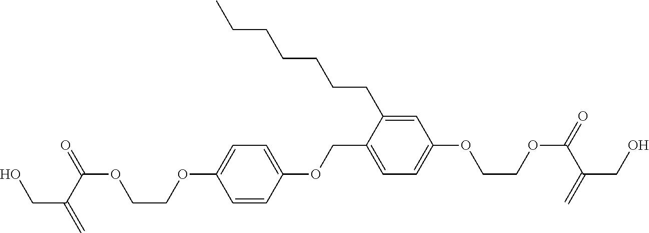 [SMILES: C=C(CO)C(=O)OCCOc1ccc(OCc2ccc(OCCOC(=O)C(=C)CO)cc2CCCCCCC)cc1] |
| 1γ-4-54 | 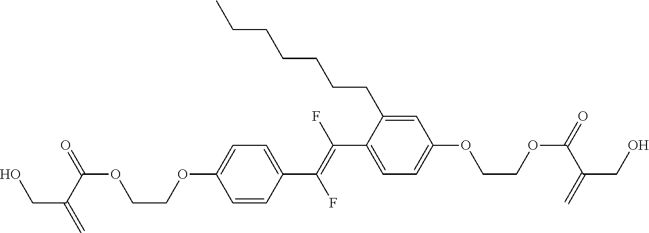 [SMILES: C=C(CO)C(=O)OCCOc1ccc(/C(F)=C(\F)c2ccc(OCCOC(=O)C(=C)CO)cc2CCCCCCC)cc1] |
| 1γ-4-55 | 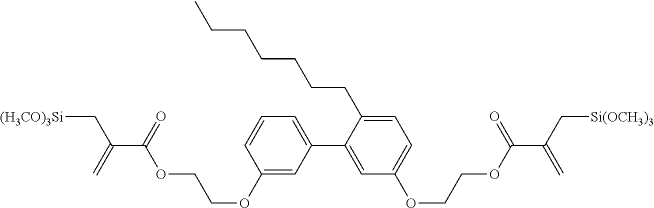 |
| 1γ-4-56 | 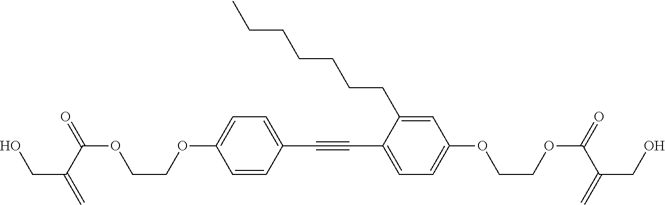 [SMILES: C=C(CO)C(=O)OCCOc1ccc(C#Cc2ccc(OCCOC(=O)C(=C)CO)cc2CCCCCCC)cc1] |
| 1γ-4-57 | 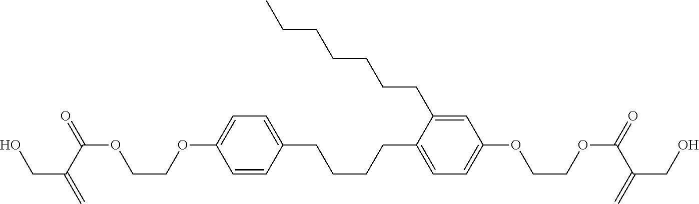 [SMILES: C=C(CO)C(=O)OCCOc1ccc(CCCCc2ccc(OCCOC(=O)C(=C)CO)cc2CCCCCCC)cc1] |
| 1γ-4-58 | 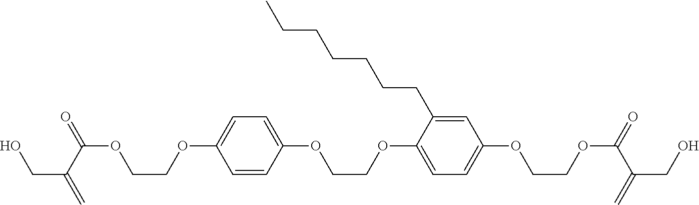 [SMILES: C=C(CO)C(=O)OCCOc1ccc(OCCOc2ccc(OCCOC(=O)C(=C)CO)cc2CCCCCCC)cc1] |
| 1γ-4-59 | 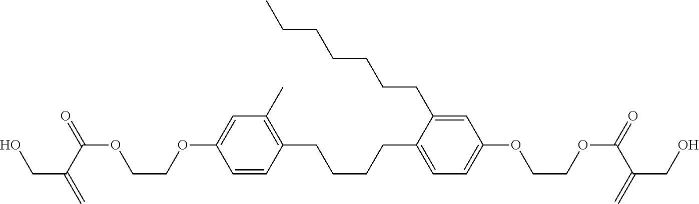 [SMILES: C=C(CO)C(=O)OCCOc1ccc(CCCCc2ccc(OCCOC(=O)C(=C)CO)cc2CCCCCCC)c(C)c1] |
| 1γ-4-60 | 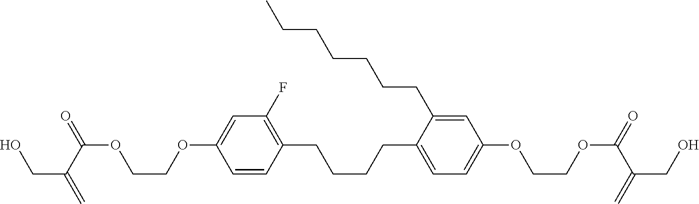 [SMILES: C=C(CO)C(=O)OCCOc1ccc(CCCCc2ccc(OCCOC(=O)C(=C)CO)cc2CCCCCCC)c(F)c1] |
| 1γ-4-61 | 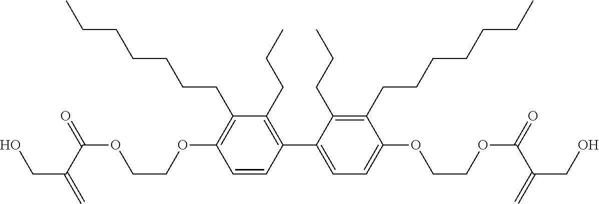 [SMILES: C=C(CO)C(=O)OCCOc1ccc(-c2ccc(OCCOC(=O)C(=C)CO)c(CCCCCCC)c2CCC)c(CCC)c1CCCCCCC] |
| 1γ-4-62 | 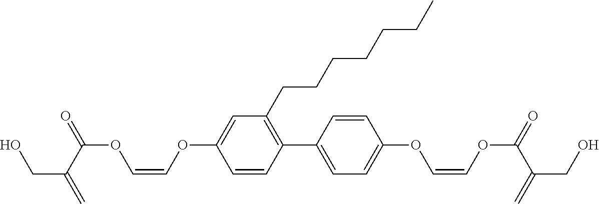 [SMILES: C=C(CO)C(=O)O/C=C\Oc1ccc(-c2ccc(O/C=C\OC(=O)C(=C)CO)cc2CCCCCCC)cc1] |
| 1γ-4-63 | 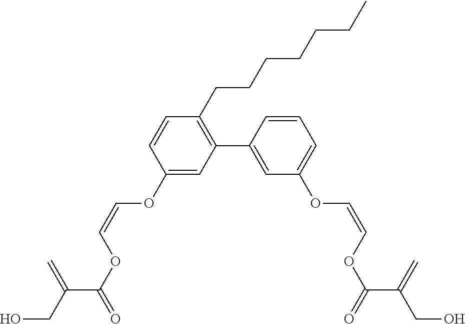 [SMILES: C=C(CO)C(=O)O/C=C\Oc1cccc(-c2cc(O/C=C\OC(=O)C(=C)CO)ccc2CCCCCCC)c1] |
| 1γ-4-64 | 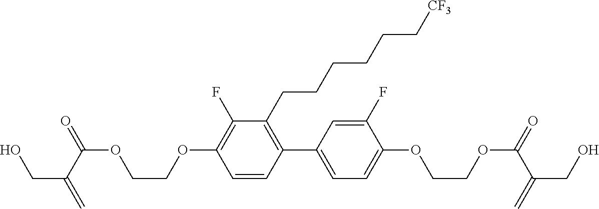 [SMILES: C=C(CO)C(=O)OCCOc1ccc(-c2ccc(OCCOC(=O)C(=C)CO)c(F)c2CCCCCCC(F)(F)F)cc1F] |
| 1γ-4-65 | 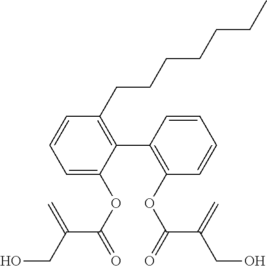 [SMILES: C=C(CO)C(=O)Oc1ccccc1-c1c(CCCCCCC)cccc1OC(=O)C(=C)CO] |
| 1γ-4-66 | 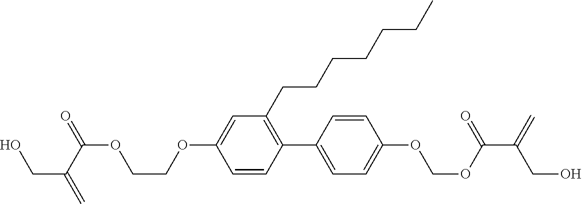 [SMILES: C=C(CO)C(=O)OCCOc1ccc(-c2ccc(OCOC(=O)C(=C)CO)cc2)c(CCCCCCC)c1] |
| 1γ-4-67 | 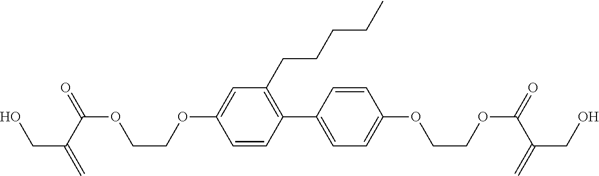 [SMILES: C=C(CO)C(=O)OCCOc1ccc(-c2ccc(OCCOC(=O)C(=C)CO)cc2CCCCC)cc1] |
| 1γ-4-68 | 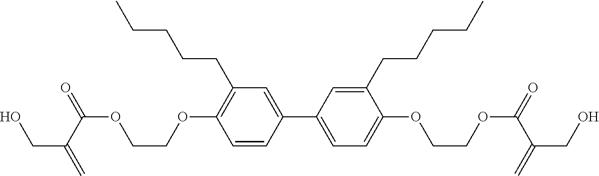 [SMILES: C=C(CO)C(=O)OCCOc1ccc(-c2ccc(OCCOC(=O)C(=C)CO)c(CCCCC)c2)cc1CCCCC] |
| 1γ-4-69 | 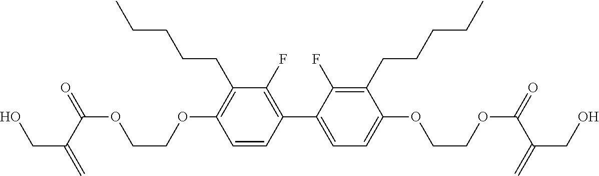 [SMILES: C=C(CO)C(=O)OCCOc1ccc(-c2ccc(OCCOC(=O)C(=C)CO)c(CCCCC)c2F)c(F)c1CCCCC] |
| 1γ-4-70 | 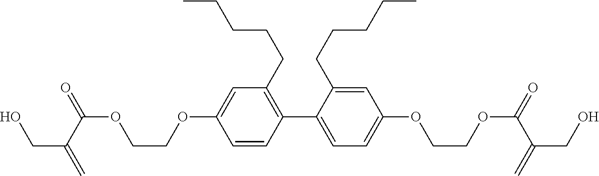 [SMILES: C=C(CO)C(=O)OCCOc1ccc(-c2ccc(OCCOC(=O)C(=C)CO)cc2CCCCC)c(CCCCC)c1] |
| 1γ-5-1 | 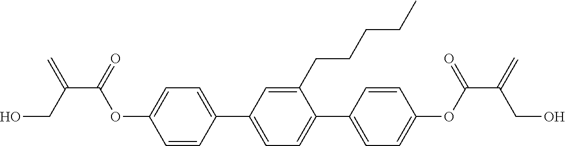 [SMILES: C=C(CO)C(=O)Oc1ccc(-c2ccc(-c3ccc(OC(=O)C(=C)CO)cc3)c(CCCCC)c2)cc1] |
| 1γ-5-2 | 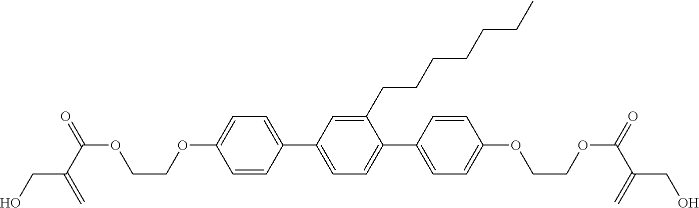 [SMILES: C=C(CO)C(=O)OCCOc1ccc(-c2ccc(-c3ccc(OCCOC(=O)C(=C)CO)cc3)c(CCCCCCC)c2)cc1] |
| 1γ-5-3 | 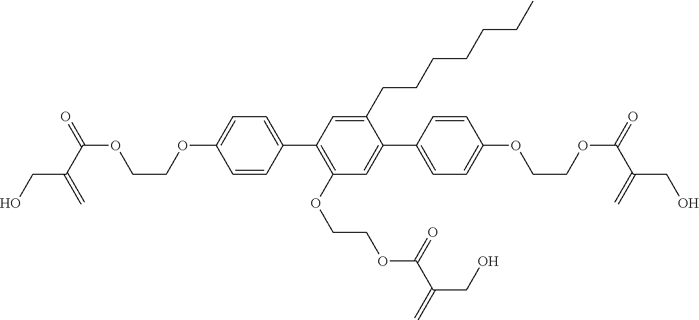 [SMILES: C=C(CO)C(=O)OCCOc1ccc(-c2cc(OCCOC(=O)C(=C)CO)c(-c3ccc(OCCOC(=O)C(=C)CO)cc3)cc2CCCCCCC)cc1] |
| 1γ-5-4 | 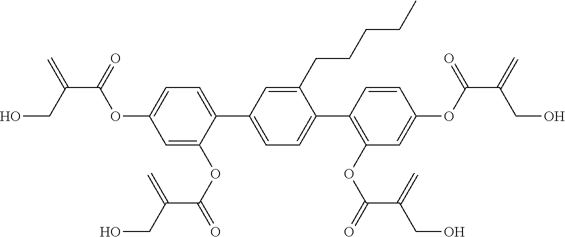 [SMILES: C=C(CO)C(=O)Oc1ccc(-c2ccc(-c3ccc(OC(=O)C(=C)CO)cc3OC(=O)C(=C)CO)c(CCCCC)c2)c(OC(=O)C(=C)CO)c1] |
| 1γ-5-5 | 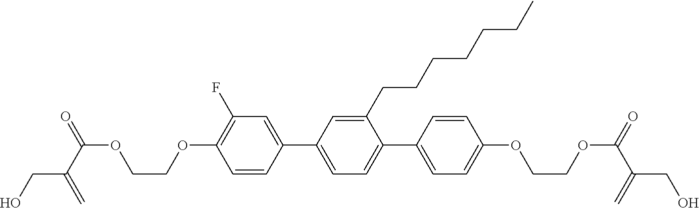 [SMILES: C=C(CO)C(=O)OCCOc1ccc(-c2ccc(-c3ccc(OCCOC(=O)C(=C)CO)c(F)c3)cc2CCCCCCC)cc1] |
| 1γ-5-6 | 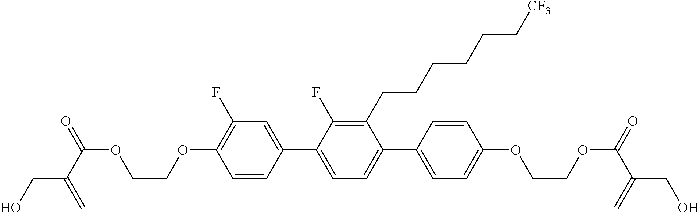 [SMILES: C=C(CO)C(=O)OCCOc1ccc(-c2ccc(-c3ccc(OCCOC(=O)C(=C)CO)c(F)c3)c(F)c2CCCCCCC(F)(F)F)cc1] |
| 1γ-5-7 | 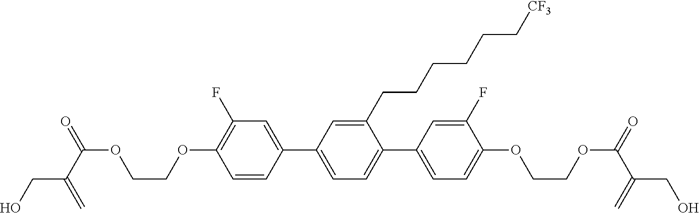 [SMILES: C=C(CO)C(=O)OCCOc1ccc(-c2ccc(-c3ccc(OCCOC(=O)C(=C)CO)c(F)c3)c(CCCCCCC(F)(F)F)c2)cc1F] |
| 1γ-5-8 | 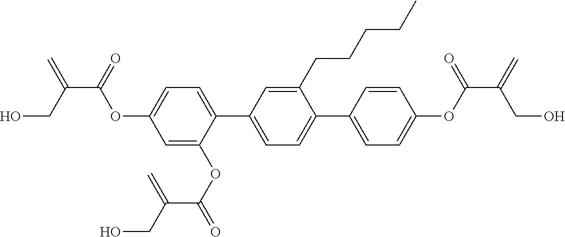 [SMILES: C=C(CO)C(=O)Oc1ccc(-c2ccc(-c3ccc(OC(=O)C(=C)CO)cc3OC(=O)C(=C)CO)cc2CCCCC)cc1] |
| 1γ-5-9 | 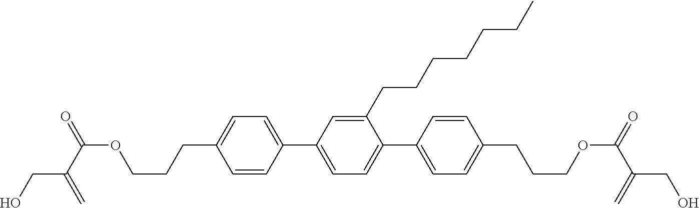 [SMILES: C=C(CO)C(=O)OCCCc1ccc(-c2ccc(-c3ccc(CCCOC(=O)C(=C)CO)cc3)c(CCCCCCC)c2)cc1] |
| 1γ-5-10 | 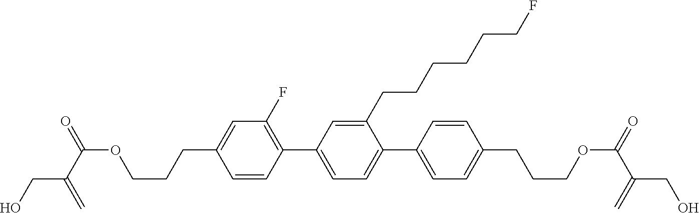 [SMILES: C=C(CO)C(=O)OCCCc1ccc(-c2ccc(-c3ccc(CCCOC(=O)C(=C)CO)cc3F)cc2CCCCCCF)cc1] |
| 1γ-5-11 | 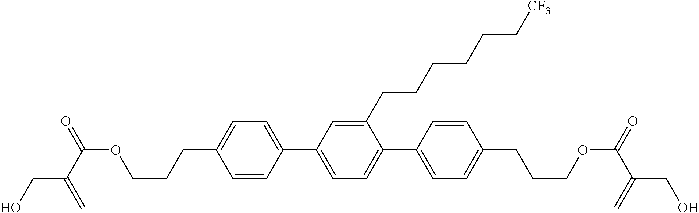 [SMILES: C=C(CO)C(=O)OCCCc1ccc(-c2ccc(-c3ccc(CCCOC(=O)C(=C)CO)cc3)c(CCCCCCC(F)(F)F)c2)cc1] |
| 1γ-5-12 | 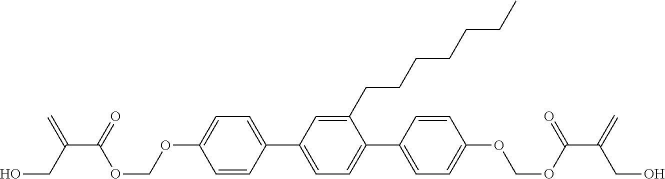 [SMILES: C=C(CO)C(=O)OCOc1ccc(-c2ccc(-c3ccc(OCOC(=O)C(=C)CO)cc3)c(CCCCCCC)c2)cc1] |
| 1γ-5-13 | 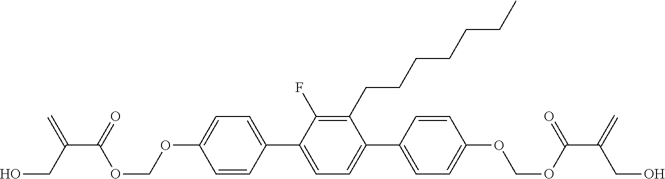 [SMILES: C=C(CO)C(=O)OCOc1ccc(-c2ccc(-c3ccc(OCOC(=O)C(=C)CO)cc3)c(CCCCCCC)c2F)cc1] |
| 1γ-5-14 | 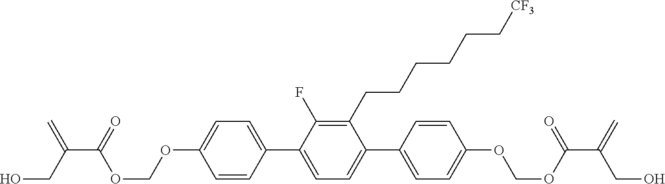 [SMILES: C=C(CO)C(=O)OCOc1ccc(-c2ccc(-c3ccc(OCOC(=O)C(=C)CO)cc3)c(CCCCCCC(F)(F)F)c2F)cc1] |
| 1γ-5-15 | 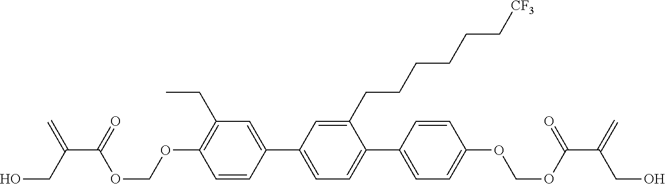 [SMILES: C=C(CO)C(=O)OCOc1ccc(-c2ccc(-c3ccc(OCOC(=O)C(=C)CO)c(CC)c3)cc2CCCCCCC(F)(F)F)cc1] |
| 1γ-5-16 | 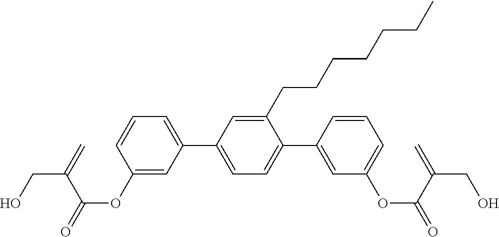 [SMILES: C=C(CO)C(=O)Oc1cccc(-c2ccc(-c3cccc(OC(=O)C(=C)CO)c3)c(CCCCCCC)c2)c1] |
| 1γ-5-17 | 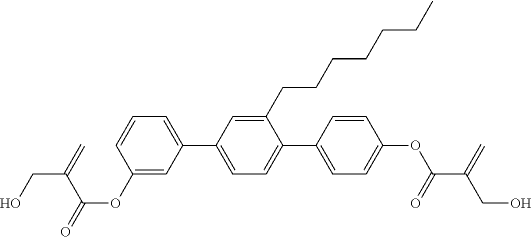 [SMILES: C=C(CO)C(=O)Oc1ccc(-c2ccc(-c3cccc(OC(=O)C(=C)CO)c3)cc2CCCCCCC)cc1] |
| 1γ-5-18 | 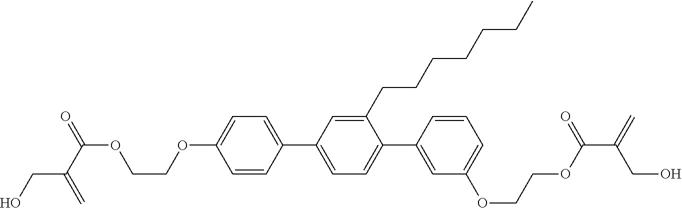 [SMILES: C=C(CO)C(=O)OCCOc1ccc(-c2ccc(-c3cccc(OCCOC(=O)C(=C)CO)c3)c(CCCCCCC)c2)cc1] |
| 1γ-5-19 | 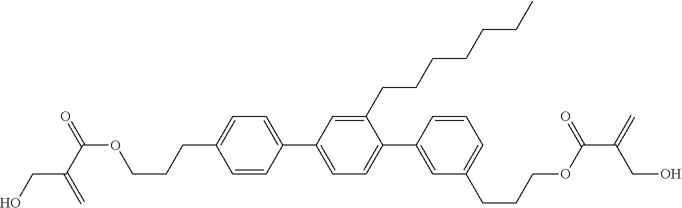 [SMILES: C=C(CO)C(=O)OCCCc1ccc(-c2ccc(-c3cccc(CCCOC(=O)C(=C)CO)c3)c(CCCCCCC)c2)cc1] |
| 1γ-5-20 | 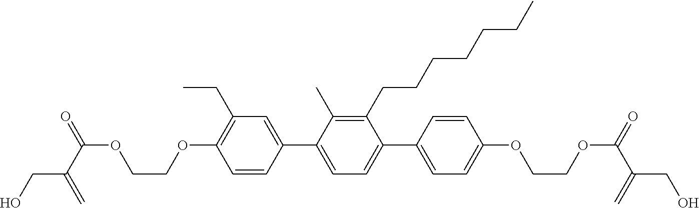 [SMILES: C=C(CO)C(=O)OCCOc1ccc(-c2ccc(-c3ccc(OCCOC(=O)C(=C)CO)c(CC)c3)c(C)c2CCCCCCC)cc1] |
| 1γ-5-21 | 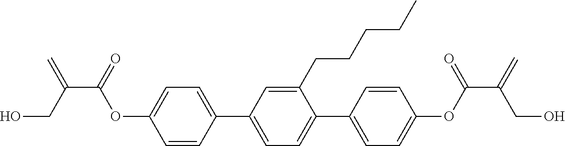 [SMILES: C=C(CO)C(=O)Oc1ccc(-c2ccc(-c3ccc(OC(=O)C(=C)CO)cc3)c(CCCCC)c2)cc1] |
| 1γ-5-22 | 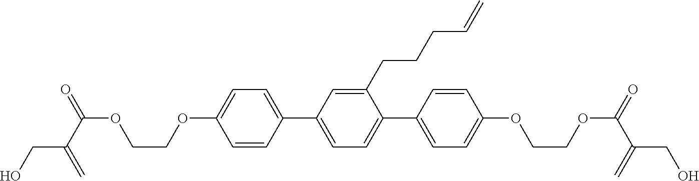 [SMILES: C=CCCCc1cc(-c2ccc(OCCOC(=O)C(=C)CO)cc2)ccc1-c1ccc(OCCOC(=O)C(=C)CO)cc1] |
| 1γ-5-23 | 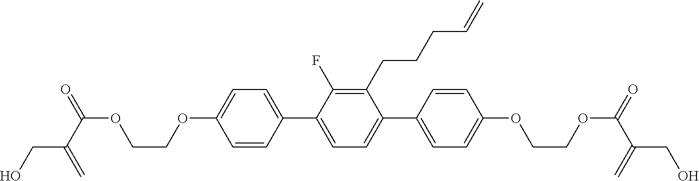 [SMILES: C=CCCCc1c(-c2ccc(OCCOC(=O)C(=C)CO)cc2)ccc(-c2ccc(OCCOC(=O)C(=C)CO)cc2)c1F] |
| 1γ-5-24 | 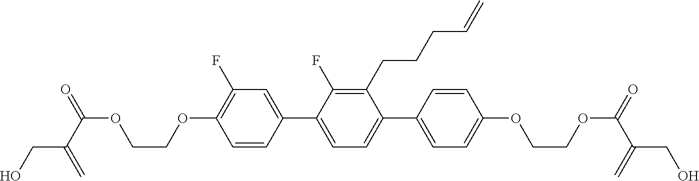 [SMILES: C=CCCCc1c(-c2ccc(OCCOC(=O)C(=C)CO)cc2)ccc(-c2ccc(OCCOC(=O)C(=C)CO)c(F)c2)c1F] |
| 1γ-5-25 | 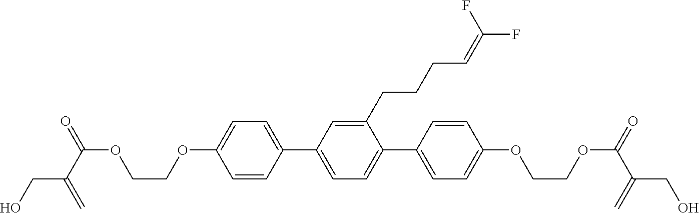 [SMILES: C=C(CO)C(=O)OCCOc1ccc(-c2ccc(-c3ccc(OCCOC(=O)C(=C)CO)cc3)c(CCCC=C(F)F)c2)cc1] |
| 1γ-5-26 | 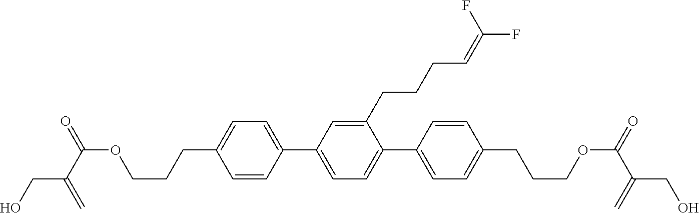 [SMILES: C=C(CO)C(=O)OCCCc1ccc(-c2ccc(-c3ccc(CCCOC(=O)C(=C)CO)cc3)c(CCCC=C(F)F)c2)cc1] |
| 1γ-5-27 | 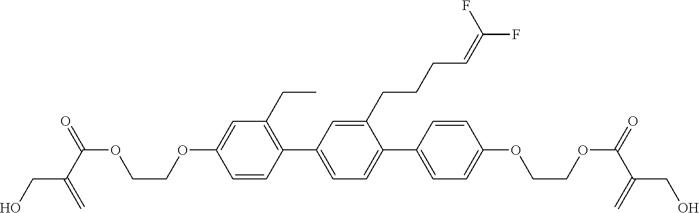 [SMILES: C=C(CO)C(=O)OCCOc1ccc(-c2ccc(-c3ccc(OCCOC(=O)C(=C)CO)cc3CC)cc2CCCC=C(F)F)cc1] |
| 1γ-5-28 | 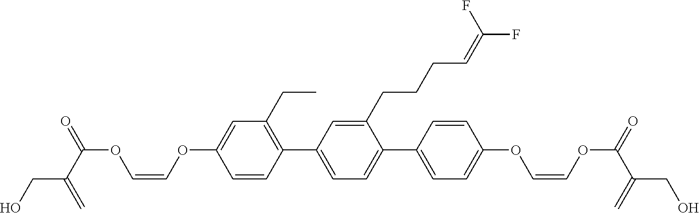 [SMILES: C=C(CO)C(=O)O/C=C\Oc1ccc(-c2ccc(-c3ccc(O/C=C\OC(=O)C(=C)CO)cc3CC)cc2CCCC=C(F)F)cc1] |
| 1γ-5-29 | 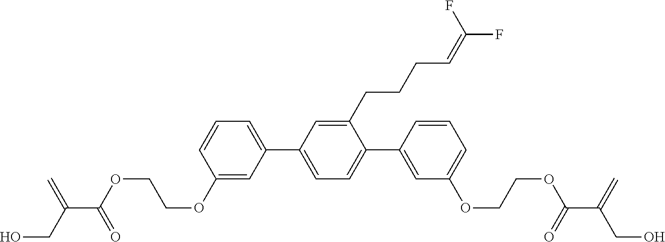 [SMILES: C=C(CO)C(=O)OCCOc1cccc(-c2ccc(-c3cccc(OCCOC(=O)C(=C)CO)c3)c(CCCC=C(F)F)c2)c1] |
| 1γ-5-30 | 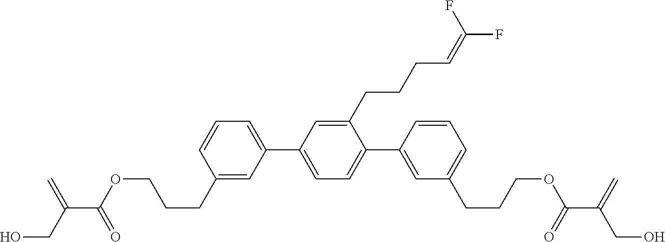 [SMILES: C=C(CO)C(=O)OCCCc1cccc(-c2ccc(-c3cccc(CCCOC(=O)C(=C)CO)c3)c(CCCC=C(F)F)c2)c1] |
| 1γ-5-31 | 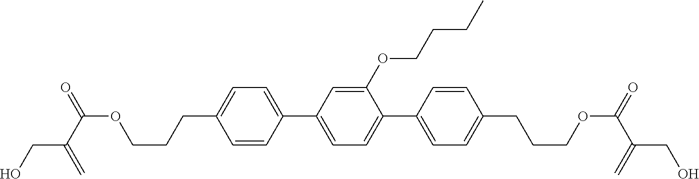 [SMILES: C=C(CO)C(=O)OCCCc1ccc(-c2ccc(-c3ccc(CCCOC(=O)C(=C)CO)cc3)c(OCCCC)c2)cc1] |
| 1γ-5-32 | 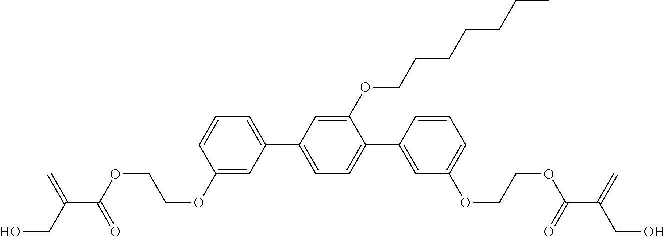 [SMILES: C=C(CO)C(=O)OCCOc1cccc(-c2ccc(-c3cccc(OCCOC(=O)C(=C)CO)c3)c(OCCCCCCC)c2)c1] |
| 1γ-5-33 | 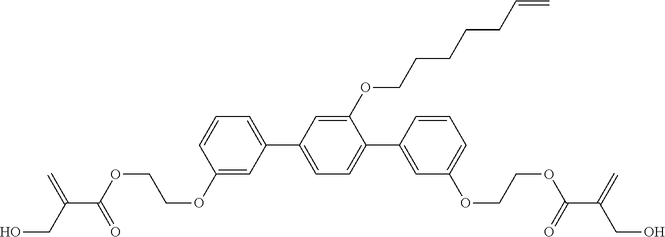 [SMILES: C=CCCCCCOc1cc(-c2cccc(OCCOC(=O)C(=C)CO)c2)ccc1-c1cccc(OCCOC(=O)C(=C)CO)c1] |
| 1γ-5-34 | 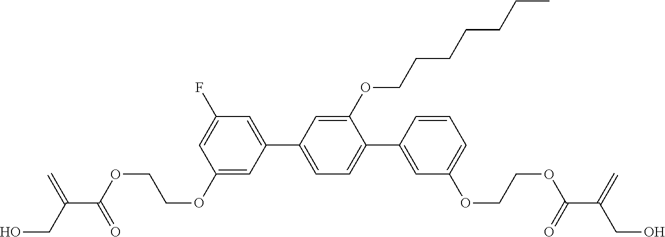 [SMILES: C=C(CO)C(=O)OCCOc1cc(F)cc(-c2ccc(-c3cccc(OCCOC(=O)C(=C)CO)c3)c(OCCCCCCC)c2)c1] |
| 1γ-5-35 | 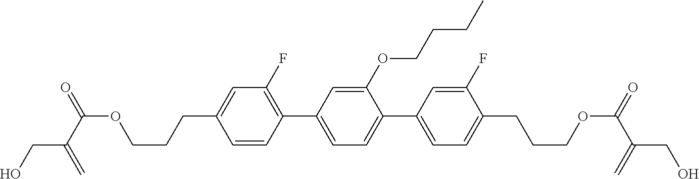 [SMILES: C=C(CO)C(=O)OCCCc1ccc(-c2ccc(-c3ccc(CCCOC(=O)C(=C)CO)c(F)c3)c(OCCCC)c2)c(F)c1] |
| 1γ-5-36 | 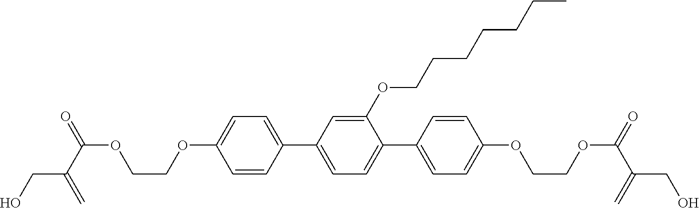 [SMILES: C=C(CO)C(=O)OCCOc1ccc(-c2ccc(-c3ccc(OCCOC(=O)C(=C)CO)cc3)c(OCCCCCCC)c2)cc1] |
| 1γ-5-37 | 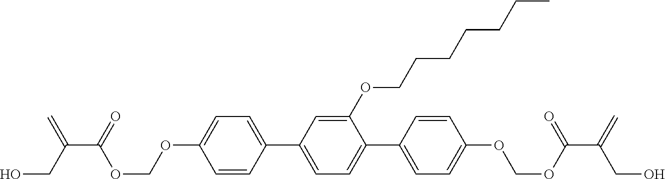 [SMILES: C=C(CO)C(=O)OCOc1ccc(-c2ccc(-c3ccc(OCOC(=O)C(=C)CO)cc3)c(OCCCCCCC)c2)cc1] |
| 1γ-5-38 | 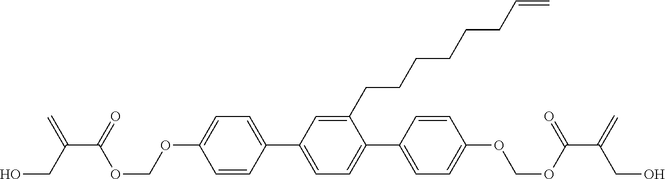 [SMILES: C=CCCCCCCc1cc(-c2ccc(OCOC(=O)C(=C)CO)cc2)ccc1-c1ccc(OCOC(=O)C(=C)CO)cc1] |
| 1γ-5-39 | 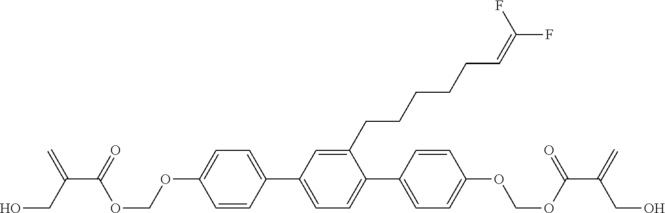 [SMILES: C=C(CO)C(=O)OCOc1ccc(-c2ccc(-c3ccc(OCOC(=O)C(=C)CO)cc3)c(CCCCCC=C(F)F)c2)cc1] |
| 1γ-5-40 | 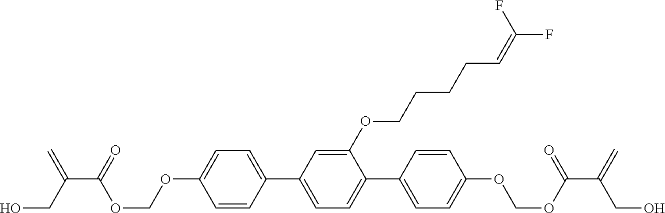 [SMILES: C=C(CO)C(=O)OCOc1ccc(-c2ccc(-c3ccc(OCOC(=O)C(=C)CO)cc3)c(OCCCCC=C(F)F)c2)cc1] |
| 1γ-5-41 | 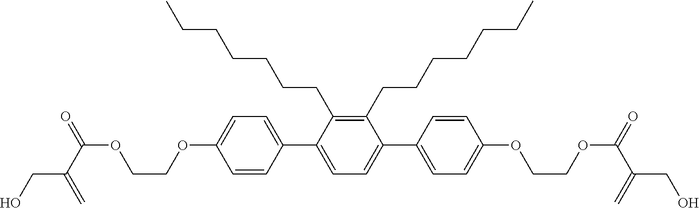 [SMILES: C=C(CO)C(=O)OCCOc1ccc(-c2ccc(-c3ccc(OCCOC(=O)C(=C)CO)cc3)c(CCCCCCC)c2CCCCCCC)cc1] |
| 1γ-5-42 | 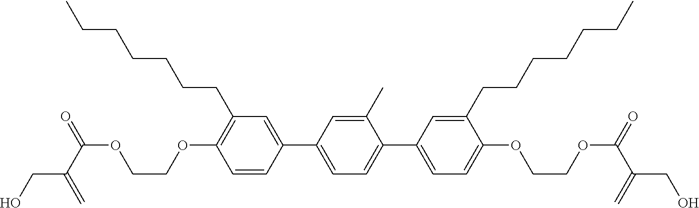 [SMILES: C=C(CO)C(=O)OCCOc1ccc(-c2ccc(-c3ccc(OCCOC(=O)C(=C)CO)c(CCCCCCC)c3)c(C)c2)cc1CCCCCCC] |
| 1γ-5-43 | 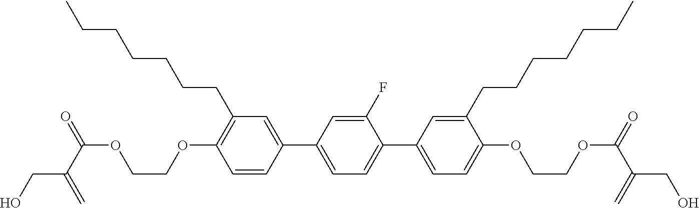 [SMILES: C=C(CO)C(=O)OCCOc1ccc(-c2ccc(-c3ccc(OCCOC(=O)C(=C)CO)c(CCCCCCC)c3)c(F)c2)cc1CCCCCCC] |
| 1γ-5-44 | 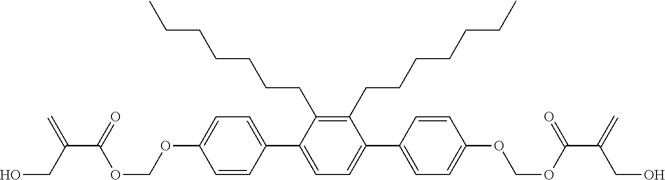 [SMILES: C=C(CO)C(=O)OCOc1ccc(-c2ccc(-c3ccc(OCOC(=O)C(=C)CO)cc3)c(CCCCCCC)c2CCCCCCC)cc1] |
| 1γ-5-45 | 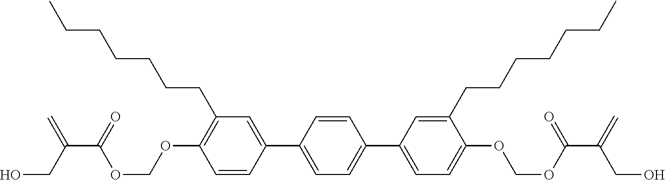 [SMILES: C=C(CO)C(=O)OCOc1ccc(-c2ccc(-c3ccc(OCOC(=O)C(=C)CO)c(CCCCCCC)c3)cc2)cc1CCCCCCC] |
| 1γ-5-46 | 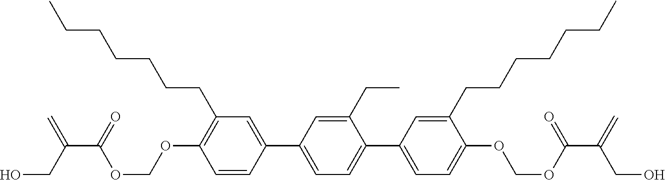 [SMILES: C=C(CO)C(=O)OCOc1ccc(-c2ccc(-c3ccc(OCOC(=O)C(=C)CO)c(CCCCCCC)c3)c(CC)c2)cc1CCCCCCC] |
| 1γ-5-47 | 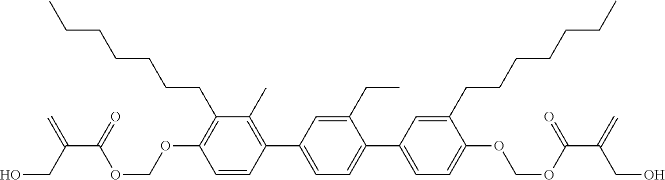 [SMILES: C=C(CO)C(=O)OCOc1ccc(-c2ccc(-c3ccc(OCOC(=O)C(=C)CO)c(CCCCCCC)c3C)cc2CC)cc1CCCCCCC] |
| 1γ-5-48 | 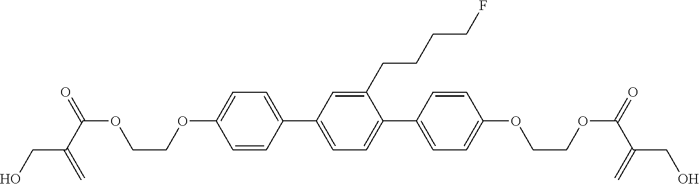 [SMILES: C=C(CO)C(=O)OCCOc1ccc(-c2ccc(-c3ccc(OCCOC(=O)C(=C)CO)cc3)c(CCCCF)c2)cc1] |
| 1γ-5-49 | 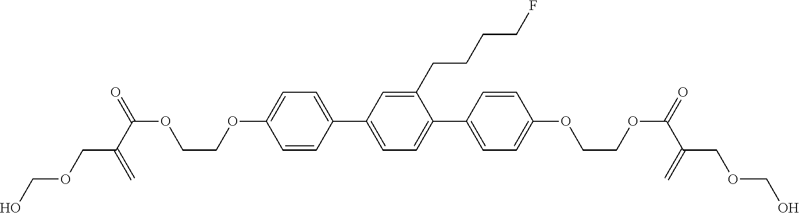 [SMILES: C=C(COCO)C(=O)OCCOc1ccc(-c2ccc(-c3ccc(OCCOC(=O)C(=C)COCO)cc3)c(CCCCF)c2)cc1] |
| 1γ-5-50 | 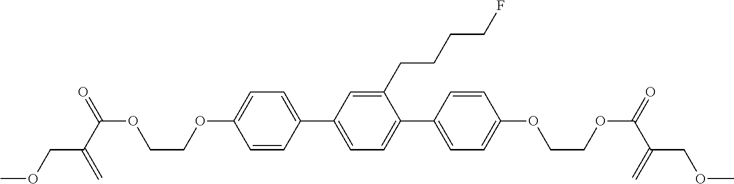 |
| 1γ-5-51 | 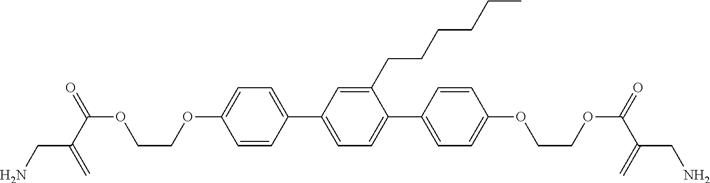 [SMILES: C=C(CN)C(=O)OCCOc1ccc(-c2ccc(-c3ccc(OCCOC(=O)C(=C)CN)cc3)c(CCCCCC)c2)cc1] |
| 1γ-5-52 | 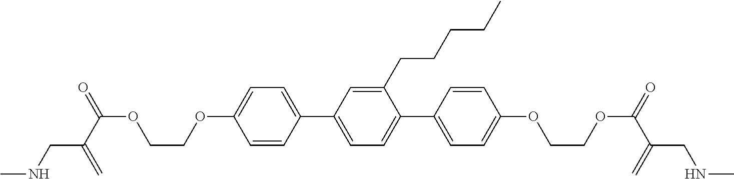 |
| 1γ-5-53 | 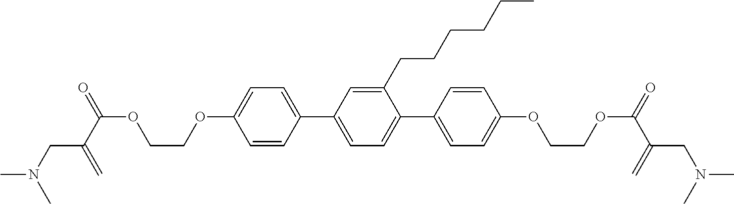 |
| 1γ-5-54 | 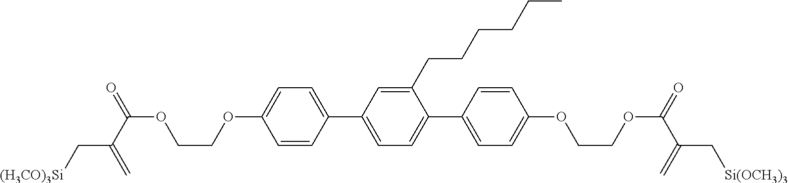 |
| 1γ-5-55 | 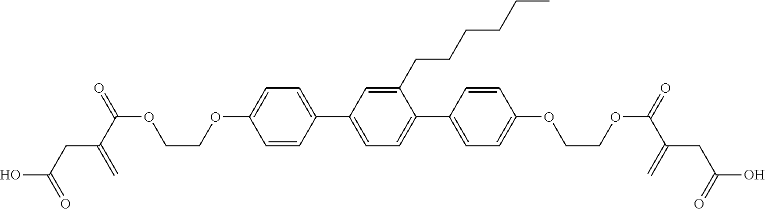 [SMILES: C=C(CC(=O)O)C(=O)OCCOc1ccc(-c2ccc(-c3ccc(OCCOC(=O)C(=C)CC(=O)O)cc3)c(CCCCCC)c2)cc1] |
| 1γ-5-56 | 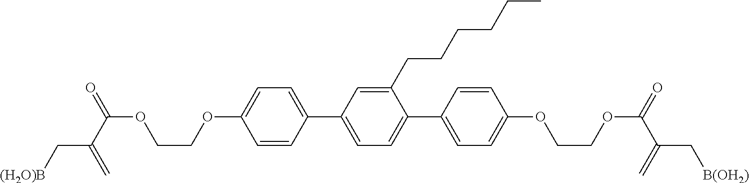 |
| 1γ-5-57 | 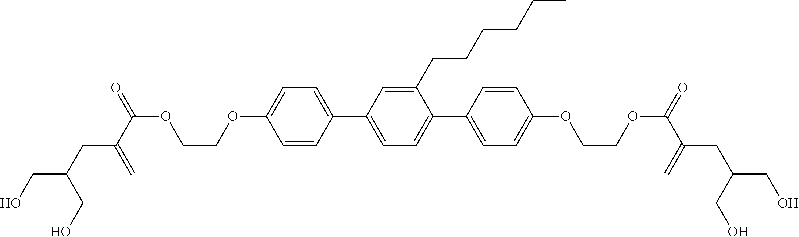 [SMILES: C=C(CC(CO)CO)C(=O)OCCOc1ccc(-c2ccc(-c3ccc(OCCOC(=O)C(=C)CC(CO)CO)cc3)c(CCCCCC)c2)cc1] |
| 1γ-5-58 | 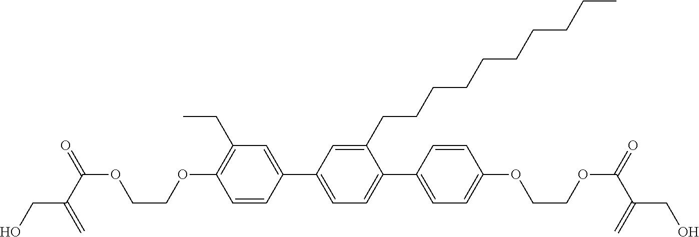 [SMILES: C=C(CO)C(=O)OCCOc1ccc(-c2ccc(-c3ccc(OCCOC(=O)C(=C)CO)c(CC)c3)cc2CCCCCCCCCC)cc1] |
| 1γ-5-59 | 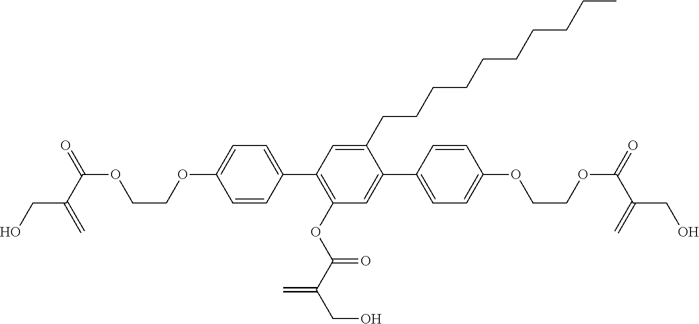 [SMILES: C=C(CO)C(=O)OCCOc1ccc(-c2cc(OC(=O)C(=C)CO)c(-c3ccc(OCCOC(=O)C(=C)CO)cc3)cc2CCCCCCCCCC)cc1] |
| 1γ-5-60 | 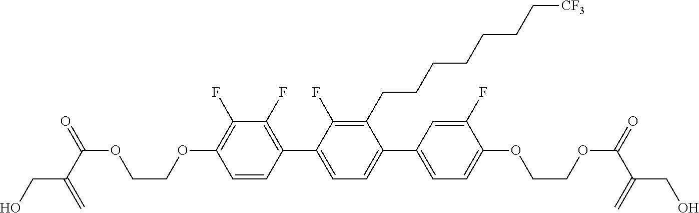 [SMILES: C=C(CO)C(=O)OCCOc1ccc(-c2ccc(-c3ccc(OCCOC(=O)C(=C)CO)c(F)c3F)c(F)c2CCCCCCCC(F)(F)F)cc1F] |
| 1γ-5-61 | 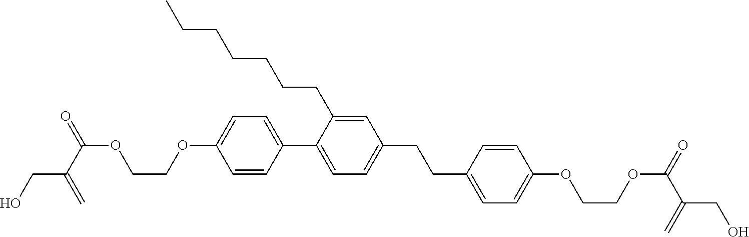 [SMILES: C=C(CO)C(=O)OCCOc1ccc(CCc2ccc(-c3ccc(OCCOC(=O)C(=C)CO)cc3)c(CCCCCCC)c2)cc1] |
| 1γ-5-62 | 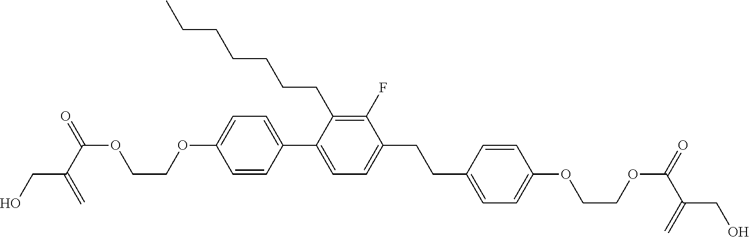 [SMILES: C=C(CO)C(=O)OCCOc1ccc(CCc2ccc(-c3ccc(OCCOC(=O)C(=C)CO)cc3)c(CCCCCCC)c2F)cc1] |
| 1γ-5-63 | 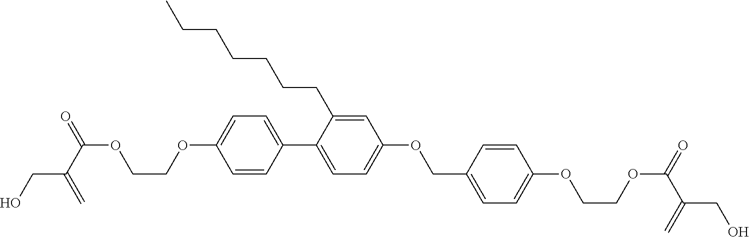 [SMILES: C=C(CO)C(=O)OCCOc1ccc(COc2ccc(-c3ccc(OCCOC(=O)C(=C)CO)cc3)c(CCCCCCC)c2)cc1] |
| 1γ-5-64 | 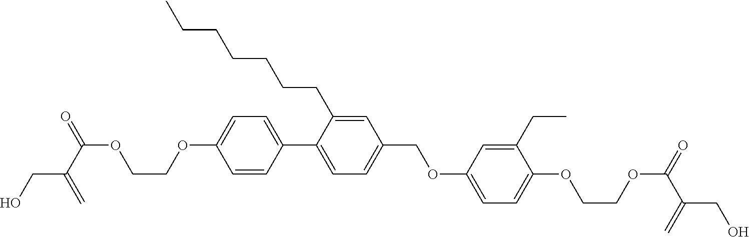 [SMILES: C=C(CO)C(=O)OCCOc1ccc(-c2ccc(COc3ccc(OCCOC(=O)C(=C)CO)c(CC)c3)cc2CCCCCCC)cc1] |
| 1γ-5-65 | 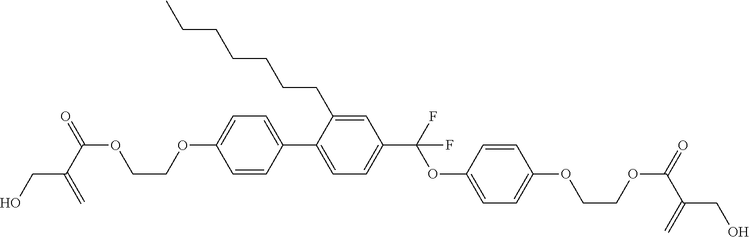 [SMILES: C=C(CO)C(=O)OCCOc1ccc(OC(F)(F)c2ccc(-c3ccc(OCCOC(=O)C(=C)CO)cc3)c(CCCCCCC)c2)cc1] |
| 1γ-5-66 | 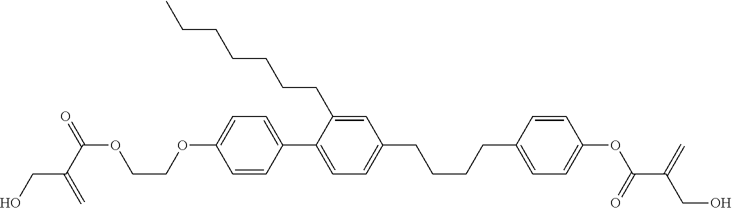 [SMILES: C=C(CO)C(=O)OCCOc1ccc(-c2ccc(CCCCc3ccc(OC(=O)C(=C)CO)cc3)cc2CCCCCCC)cc1] |
| 1γ-5-67 | 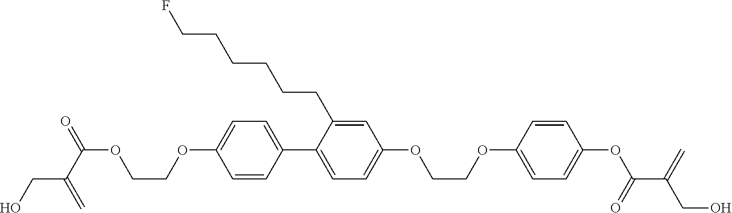 [SMILES: C=C(CO)C(=O)OCCOc1ccc(-c2ccc(OCCOc3ccc(OC(=O)C(=C)CO)cc3)cc2CCCCCCF)cc1] |
| 1γ-5-68 | 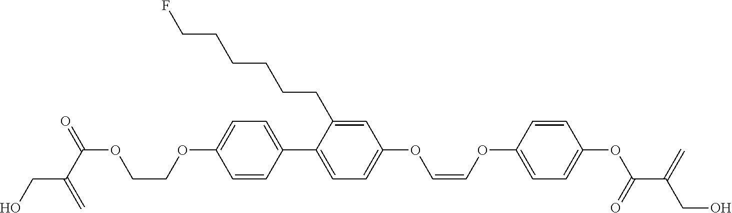 [SMILES: C=C(CO)C(=O)OCCOc1ccc(-c2ccc(O/C=C\Oc3ccc(OC(=O)C(=C)CO)cc3)cc2CCCCCCF)cc1] |
| 1γ-5-69 | 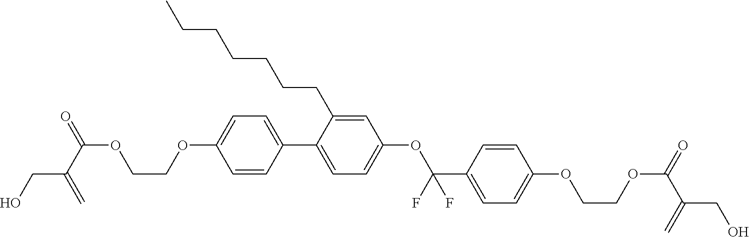 [SMILES: C=C(CO)C(=O)OCCOc1ccc(-c2ccc(OC(F)(F)c3ccc(OCCOC(=O)C(=C)CO)cc3)cc2CCCCCCC)cc1] |
| 1γ-5-70 | 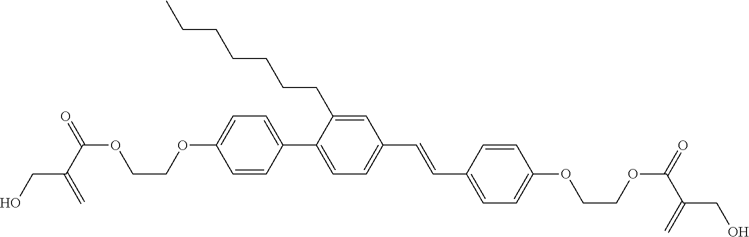 [SMILES: C=C(CO)C(=O)OCCOc1ccc(/C=C/c2ccc(-c3ccc(OCCOC(=O)C(=C)CO)cc3)c(CCCCCCC)c2)cc1] |
| 1γ-5-71 | 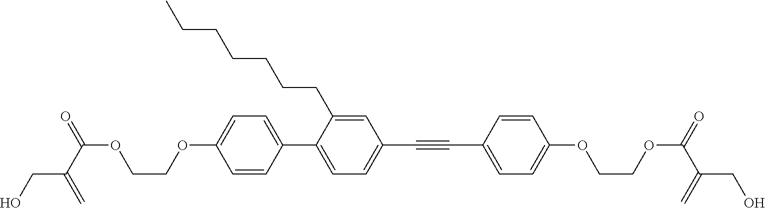 [SMILES: C=C(CO)C(=O)OCCOc1ccc(C#Cc2ccc(-c3ccc(OCCOC(=O)C(=C)CO)cc3)c(CCCCCCC)c2)cc1] |
| 1γ-5-72 | 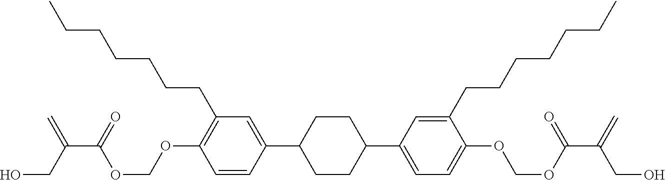 [SMILES: C=C(CO)C(=O)OCOc1ccc(C2CCC(c3ccc(OCOC(=O)C(=C)CO)c(CCCCCCC)c3)CC2)cc1CCCCCCC] |
| 1γ-5-73 | 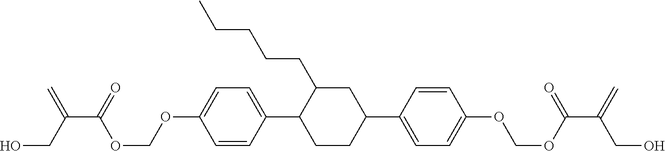 [SMILES: C=C(CO)C(=O)OCOc1ccc(C2CCC(c3ccc(OCOC(=O)C(=C)CO)cc3)C(CCCCC)C2)cc1] |
| 1γ-5-74 | 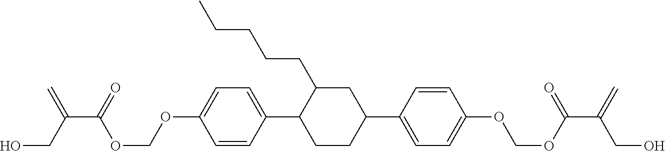 [SMILES: C=C(CO)C(=O)OCOc1ccc(C2CCC(c3ccc(OCOC(=O)C(=C)CO)cc3)C(CCCCC)C2)cc1] |
| 1γ-5-75 | 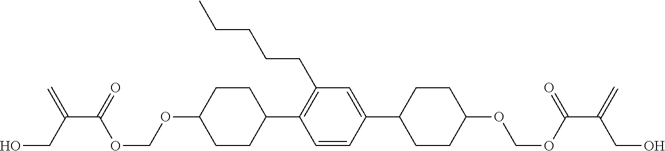 [SMILES: C=C(CO)C(=O)OCOC1CCC(c2ccc(C3CCC(OCOC(=O)C(=C)CO)CC3)c(CCCCC)c2)CC1] |
| 1γ-6-1 | 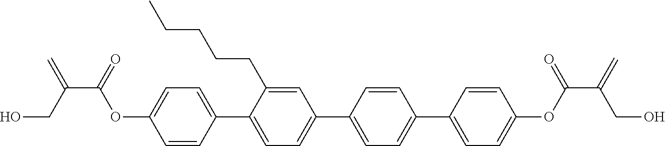 [SMILES: C=C(CO)C(=O)Oc1ccc(-c2ccc(-c3ccc(-c4ccc(OC(=O)C(=C)CO)cc4)c(CCCCC)c3)cc2)cc1] |
| 1γ-6-2 | 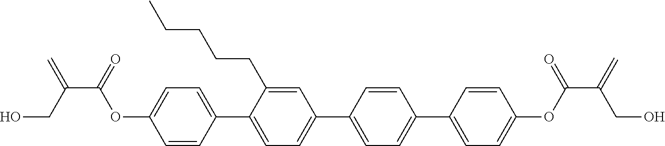 [SMILES: C=C(CO)C(=O)Oc1ccc(-c2ccc(-c3ccc(-c4ccc(OC(=O)C(=C)CO)cc4)c(CCCCC)c3)cc2)cc1] |
| 1γ-6-3 | 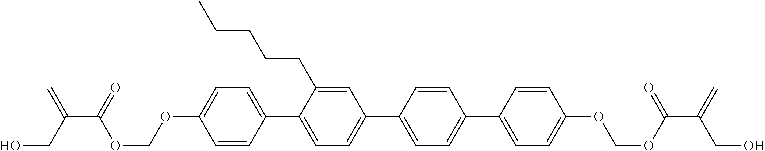 [SMILES: C=C(CO)C(=O)OCOc1ccc(-c2ccc(-c3ccc(-c4ccc(OCOC(=O)C(=C)CO)cc4)c(CCCCC)c3)cc2)cc1] |
| 1γ-6-4 | 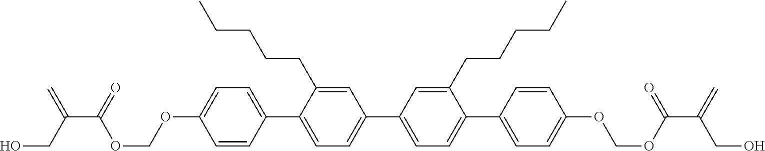 [SMILES: C=C(CO)C(=O)OCOc1ccc(-c2ccc(-c3ccc(-c4ccc(OCOC(=O)C(=C)CO)cc4)c(CCCCC)c3)cc2CCCCC)cc1] |
| 1γ-6-5 | 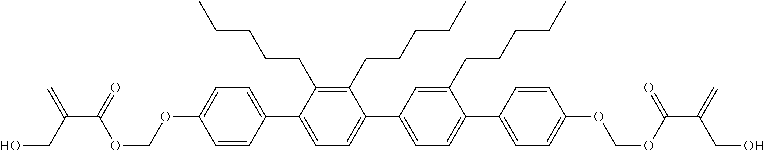 [SMILES: C=C(CO)C(=O)OCOc1ccc(-c2ccc(-c3ccc(-c4ccc(OCOC(=O)C(=C)CO)cc4)c(CCCCC)c3CCCCC)cc2CCCCC)cc1] |
| 1γ-6-6 | 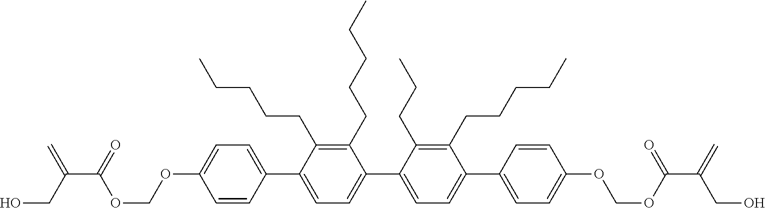 [SMILES: C=C(CO)C(=O)OCOc1ccc(-c2ccc(-c3ccc(-c4ccc(OCOC(=O)C(=C)CO)cc4)c(CCCCC)c3CCCCC)c(CCC)c2CCCCC)cc1] |
| 1γ-6-7 | 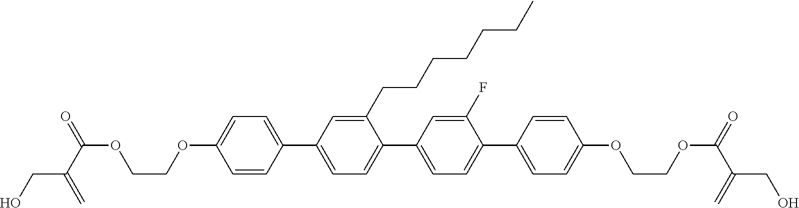 [SMILES: C=C(CO)C(=O)OCCOc1ccc(-c2ccc(-c3ccc(-c4ccc(OCCOC(=O)C(=C)CO)cc4)c(F)c3)c(CCCCCCC)c2)cc1] |
| 1γ-6-8 | 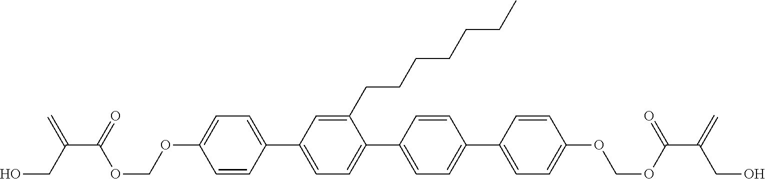 [SMILES: C=C(CO)C(=O)OCOc1ccc(-c2ccc(-c3ccc(-c4ccc(OCOC(=O)C(=C)CO)cc4)cc3CCCCCCC)cc2)cc1] |
| 1γ-6-9 | 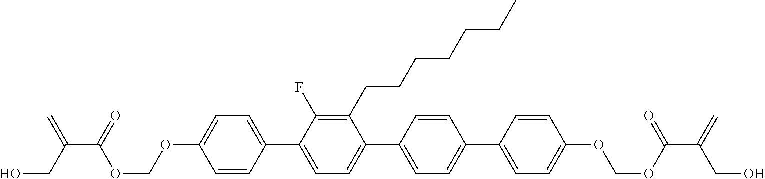 [SMILES: C=C(CO)C(=O)OCOc1ccc(-c2ccc(-c3ccc(-c4ccc(OCOC(=O)C(=C)CO)cc4)c(F)c3CCCCCCC)cc2)cc1] |
| 1γ-6-10 | 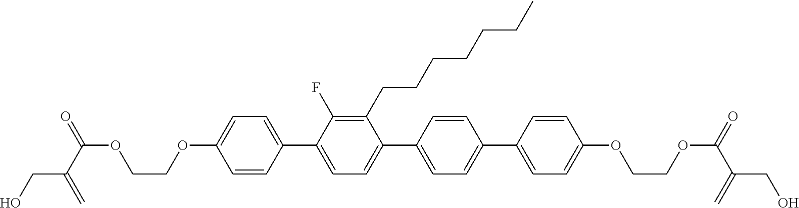 [SMILES: C=C(CO)C(=O)OCCOc1ccc(-c2ccc(-c3ccc(-c4ccc(OCCOC(=O)C(=C)CO)cc4)c(F)c3CCCCCCC)cc2)cc1] |
| 1γ-6-11 | 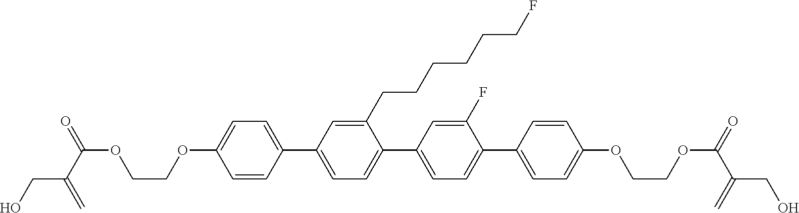 [SMILES: C=C(CO)C(=O)OCCOc1ccc(-c2ccc(-c3ccc(-c4ccc(OCCOC(=O)C(=C)CO)cc4)c(F)c3)c(CCCCCCF)c2)cc1] |
| 1γ-6-12 | 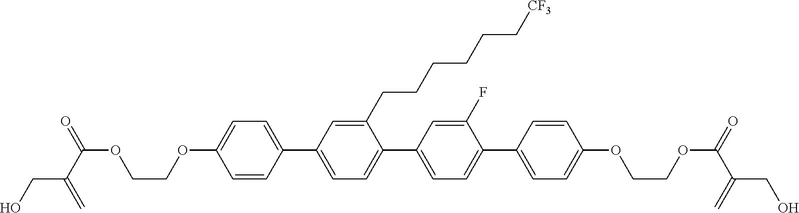 [SMILES: C=C(CO)C(=O)OCCOc1ccc(-c2ccc(-c3ccc(-c4ccc(OCCOC(=O)C(=C)CO)cc4)c(F)c3)c(CCCCCCC(F)(F)F)c2)cc1] |
| 1γ-6-13 | 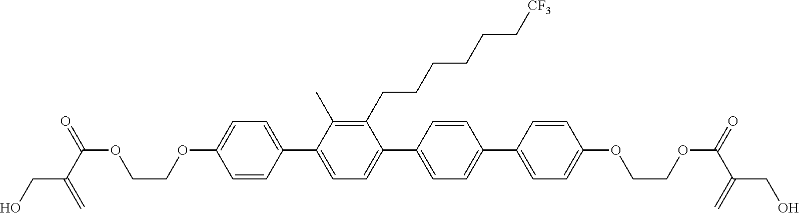 [SMILES: C=C(CO)C(=O)OCCOc1ccc(-c2ccc(-c3ccc(-c4ccc(OCCOC(=O)C(=C)CO)cc4)c(C)c3CCCCCCC(F)(F)F)cc2)cc1] |
| 1γ-6-14 | 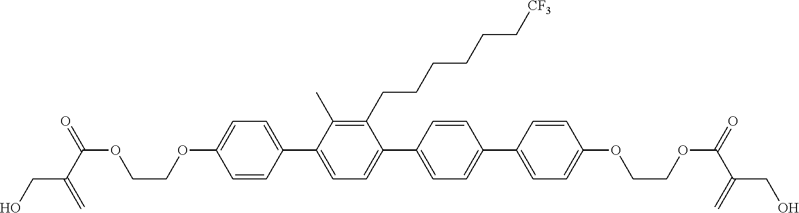 [SMILES: C=C(CO)C(=O)OCCOc1ccc(-c2ccc(-c3ccc(-c4ccc(OCCOC(=O)C(=C)CO)cc4)c(C)c3CCCCCCC(F)(F)F)cc2)cc1] |
| 1γ-6-15 | 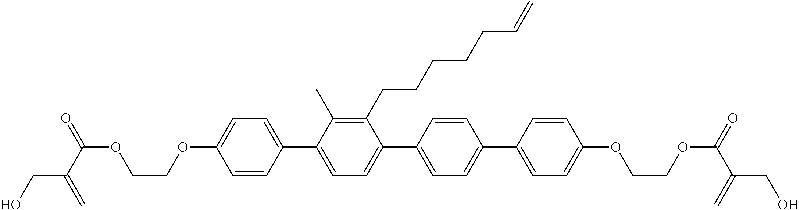 [SMILES: C=CCCCCCc1c(-c2ccc(-c3ccc(OCCOC(=O)C(=C)CO)cc3)cc2)ccc(-c2ccc(OCCOC(=O)C(=C)CO)cc2)c1C] |
| 1γ-6-16 | 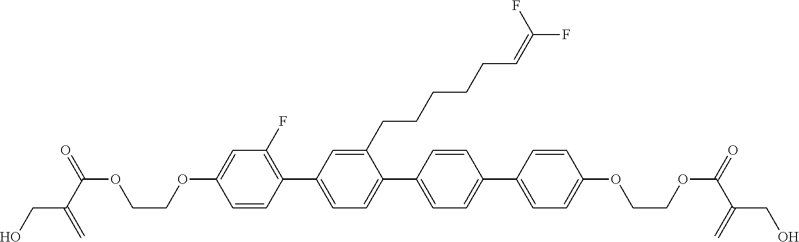 [SMILES: C=C(CO)C(=O)OCCOc1ccc(-c2ccc(-c3ccc(-c4ccc(OCCOC(=O)C(=C)CO)cc4F)cc3CCCCCC=C(F)F)cc2)cc1] |
| 1γ-6-17 | 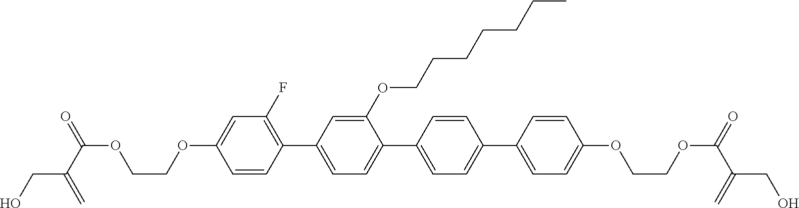 [SMILES: C=C(CO)C(=O)OCCOc1ccc(-c2ccc(-c3ccc(-c4ccc(OCCOC(=O)C(=C)CO)cc4F)cc3OCCCCCCC)cc2)cc1] |
| 1γ-6-18 | 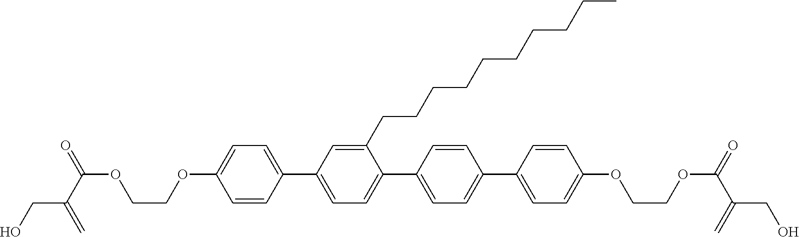 [SMILES: C=C(CO)C(=O)OCCOc1ccc(-c2ccc(-c3ccc(-c4ccc(OCCOC(=O)C(=C)CO)cc4)cc3CCCCCCCCCC)cc2)cc1] |
| 1γ-6-19 | 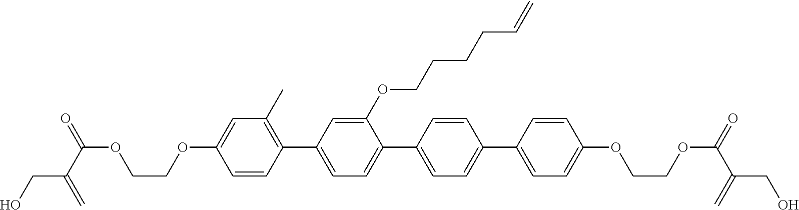 [SMILES: C=CCCCCOc1cc(-c2ccc(OCCOC(=O)C(=C)CO)cc2C)ccc1-c1ccc(-c2ccc(OCCOC(=O)C(=C)CO)cc2)cc1] |
| 1γ-6-20 | 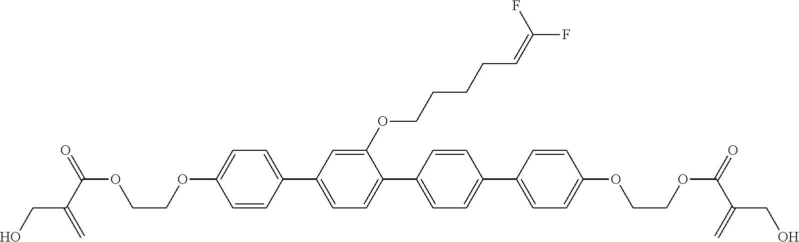 [SMILES: C=C(CO)C(=O)OCCOc1ccc(-c2ccc(-c3ccc(-c4ccc(OCCOC(=O)C(=C)CO)cc4)cc3OCCCCC=C(F)F)cc2)cc1] |
| 1γ-6-21 | 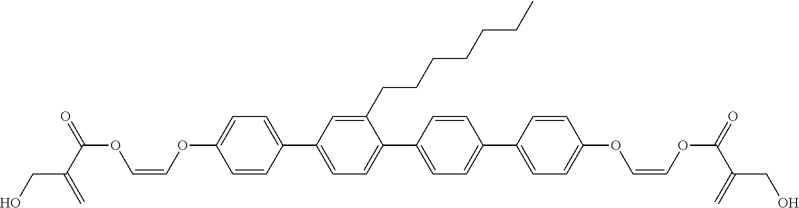 [SMILES: C=C(CO)C(=O)O/C=C\Oc1ccc(-c2ccc(-c3ccc(-c4ccc(O/C=C\OC(=O)C(=C)CO)cc4)cc3CCCCCCC)cc2)cc1] |
| 1γ-6-22 | 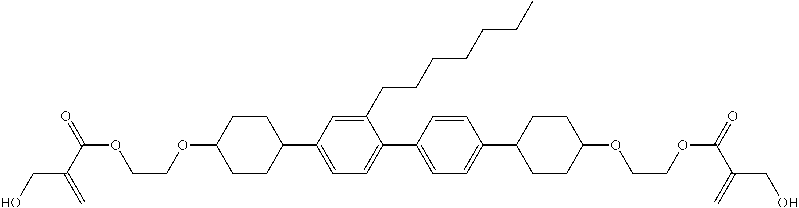 [SMILES: C=C(CO)C(=O)OCCOC1CCC(c2ccc(-c3ccc(C4CCC(OCCOC(=O)C(=C)CO)CC4)cc3CCCCCCC)cc2)CC1] |
| 1γ-6-23 | 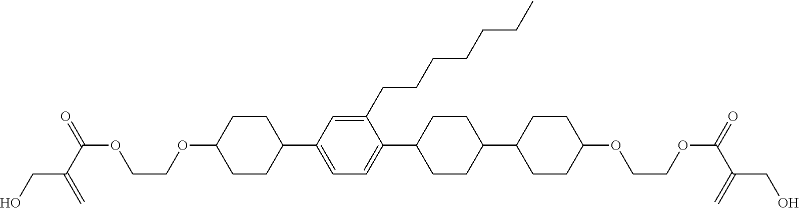 [SMILES: C=C(CO)C(=O)OCCOC1CCC(c2ccc(C3CCC(C4CCC(OCCOC(=O)C(=C)CO)CC4)CC3)c(CCCCCCC)c2)CC1] |
| 1γ-6-24 | 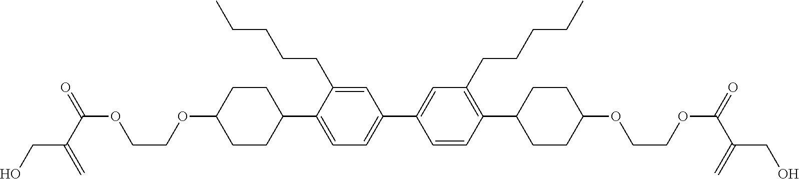 [SMILES: C=C(CO)C(=O)OCCOC1CCC(c2ccc(-c3ccc(C4CCC(OCCOC(=O)C(=C)CO)CC4)c(CCCCC)c3)cc2CCCCC)CC1] |
| 1γ-6-25 | 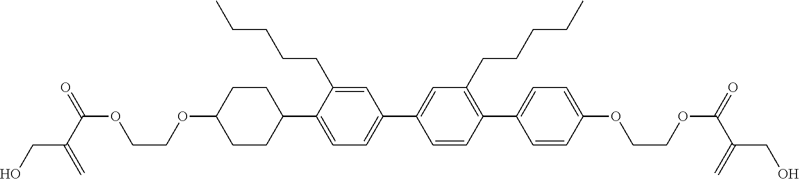 [SMILES: C=C(CO)C(=O)OCCOc1ccc(-c2ccc(-c3ccc(C4CCC(OCCOC(=O)C(=C)CO)CC4)c(CCCCC)c3)cc2CCCCC)cc1] |
| 1γ-6-26 | 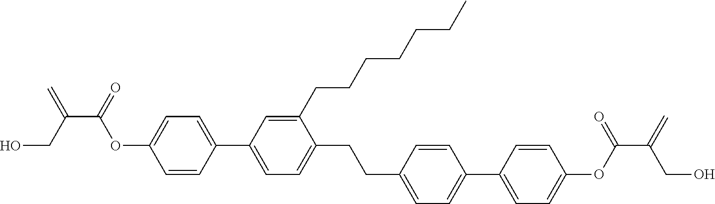 [SMILES: C=C(CO)C(=O)Oc1ccc(-c2ccc(CCc3ccc(-c4ccc(OC(=O)C(=C)CO)cc4)cc3CCCCCCC)cc2)cc1] |
| 1γ-6-27 | 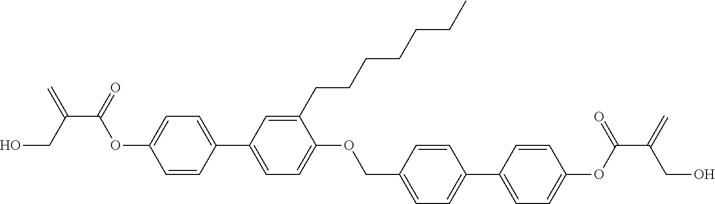 [SMILES: C=C(CO)C(=O)Oc1ccc(-c2ccc(COc3ccc(-c4ccc(OC(=O)C(=C)CO)cc4)cc3CCCCCCC)cc2)cc1] |
| 1γ-6-28 | 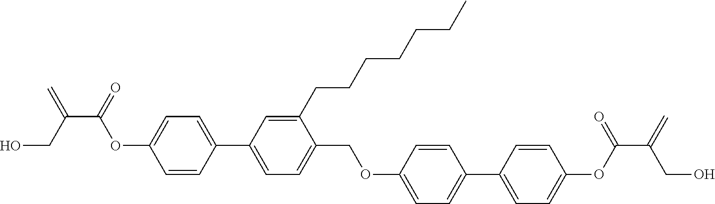 [SMILES: C=C(CO)C(=O)Oc1ccc(-c2ccc(OCc3ccc(-c4ccc(OC(=O)C(=C)CO)cc4)cc3CCCCCCC)cc2)cc1] |
| 1γ-6-29 | 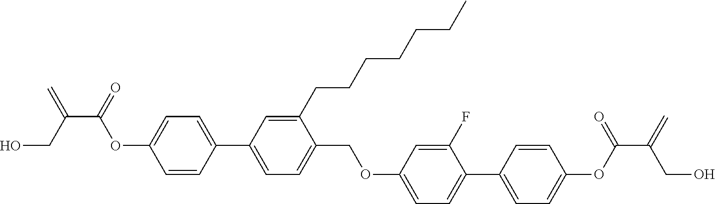 [SMILES: C=C(CO)C(=O)Oc1ccc(-c2ccc(COc3ccc(-c4ccc(OC(=O)C(=C)CO)cc4)c(F)c3)c(CCCCCCC)c2)cc1] |
| 1γ-6-30 | 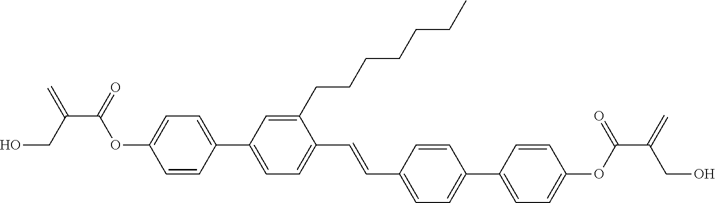 [SMILES: C=C(CO)C(=O)Oc1ccc(-c2ccc(/C=C/c3ccc(-c4ccc(OC(=O)C(=C)CO)cc4)cc3CCCCCCC)cc2)cc1] |
| 1γ-6-31 | 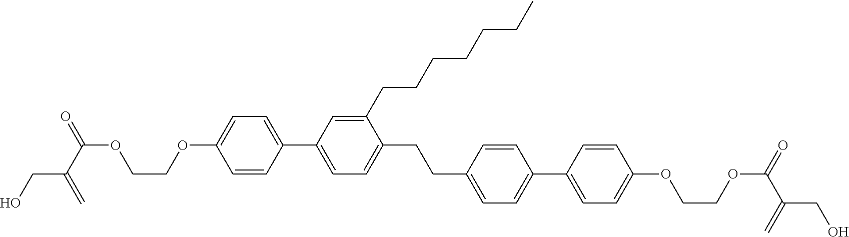 [SMILES: C=C(CO)C(=O)OCCOc1ccc(-c2ccc(CCc3ccc(-c4ccc(OCCOC(=O)C(=C)CO)cc4)cc3CCCCCCC)cc2)cc1] |
| 1γ-6-32 | 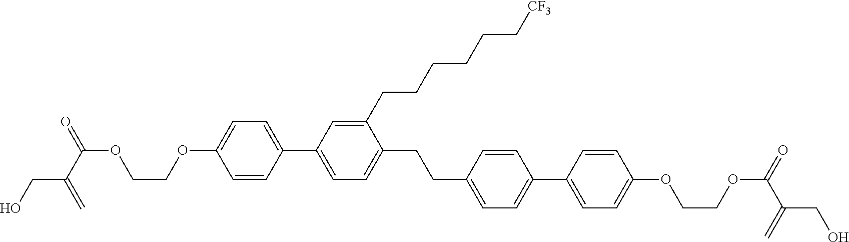 [SMILES: C=C(CO)C(=O)OCCOc1ccc(-c2ccc(CCc3ccc(-c4ccc(OCCOC(=O)C(=C)CO)cc4)cc3CCCCCCC(F)(F)F)cc2)cc1] |
| 1γ-6-33 | 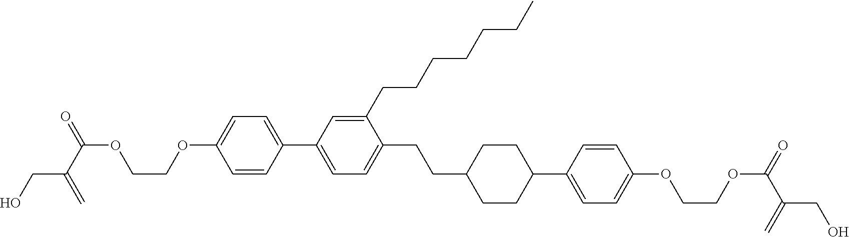 [SMILES: C=C(CO)C(=O)OCCOc1ccc(-c2ccc(CCC3CCC(c4ccc(OCCOC(=O)C(=C)CO)cc4)CC3)c(CCCCCCC)c2)cc1] |
| 1γ-6-34 | 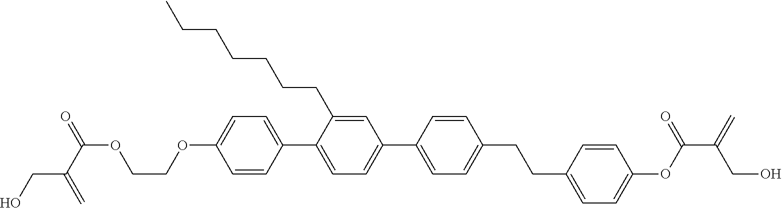 [SMILES: C=C(CO)C(=O)OCCOc1ccc(-c2ccc(-c3ccc(CCc4ccc(OC(=O)C(=C)CO)cc4)cc3)cc2CCCCCCC)cc1] |
| 1γ-6-35 | 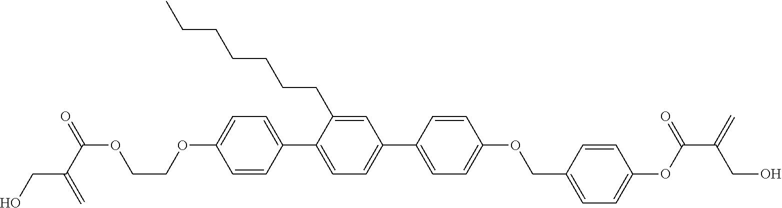 [SMILES: C=C(CO)C(=O)OCCOc1ccc(-c2ccc(-c3ccc(OCc4ccc(OC(=O)C(=C)CO)cc4)cc3)cc2CCCCCCC)cc1] |
| 1γ-6-36 | 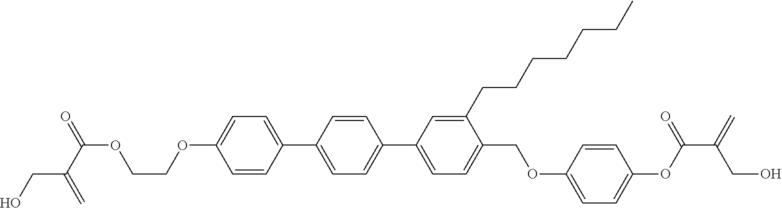 [SMILES: C=C(CO)C(=O)OCCOc1ccc(-c2ccc(-c3ccc(COc4ccc(OC(=O)C(=C)CO)cc4)c(CCCCCCC)c3)cc2)cc1] |
| 1γ-6-37 | 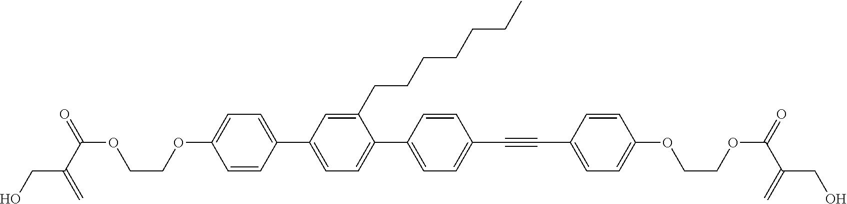 [SMILES: C=C(CO)C(=O)OCCOc1ccc(C#Cc2ccc(-c3ccc(-c4ccc(OCCOC(=O)C(=C)CO)cc4)cc3CCCCCCC)cc2)cc1] |
| 1γ-6-38 | 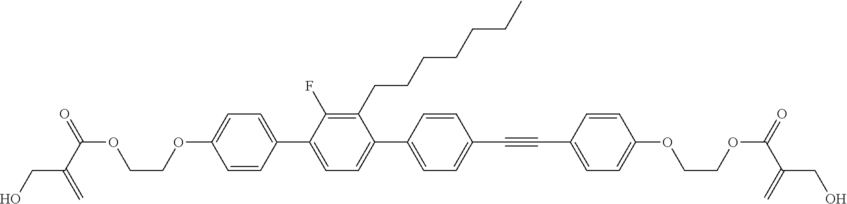 [SMILES: C=C(CO)C(=O)OCCOc1ccc(C#Cc2ccc(-c3ccc(-c4ccc(OCCOC(=O)C(=C)CO)cc4)c(F)c3CCCCCCC)cc2)cc1] |
| 1γ-6-39 | 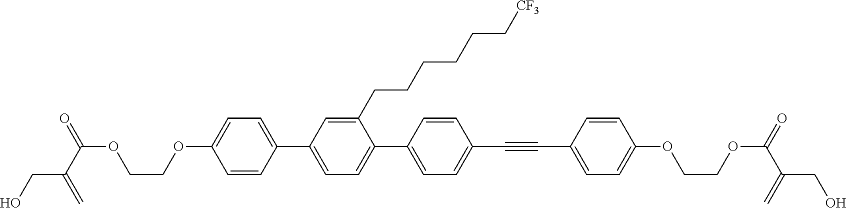 [SMILES: C=C(CO)C(=O)OCCOc1ccc(C#Cc2ccc(-c3ccc(-c4ccc(OCCOC(=O)C(=C)CO)cc4)cc3CCCCCCC(F)(F)F)cc2)cc1] |
| 1γ-6-40 | 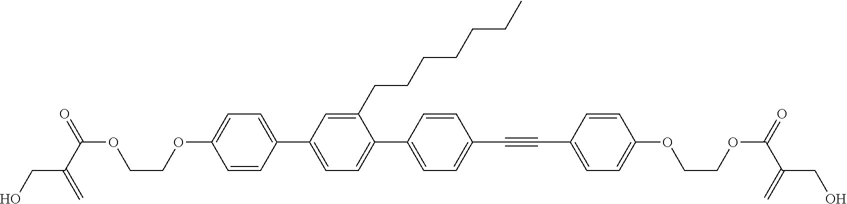 [SMILES: C=C(CO)C(=O)OCCOc1ccc(C#Cc2ccc(-c3ccc(-c4ccc(OCCOC(=O)C(=C)CO)cc4)cc3CCCCCCC)cc2)cc1] |
| 1γ-6-41 | 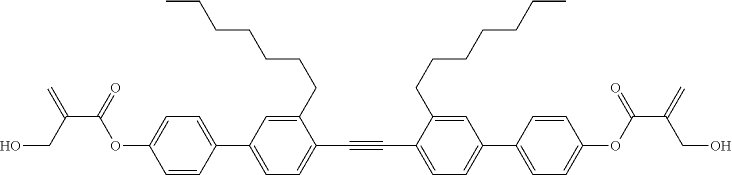 [SMILES: C=C(CO)C(=O)Oc1ccc(-c2ccc(C#Cc3ccc(-c4ccc(OC(=O)C(=C)CO)cc4)cc3CCCCCCC)c(CCCCCCC)c2)cc1] |
| 1γ-6-42 | 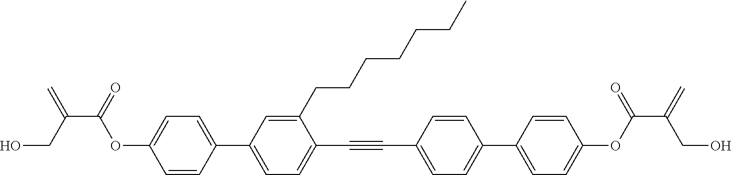 [SMILES: C=C(CO)C(=O)Oc1ccc(-c2ccc(C#Cc3ccc(-c4ccc(OC(=O)C(=C)CO)cc4)cc3CCCCCCC)cc2)cc1] |
| 1γ-6-43 | 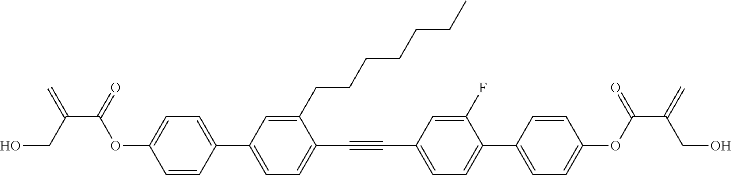 [SMILES: C=C(CO)C(=O)Oc1ccc(-c2ccc(C#Cc3ccc(-c4ccc(OC(=O)C(=C)CO)cc4)c(F)c3)c(CCCCCCC)c2)cc1] |
| 1γ-6-44 | 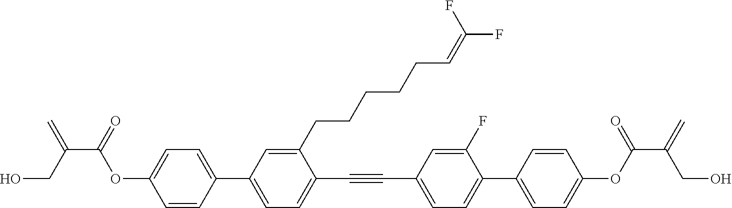 [SMILES: C=C(CO)C(=O)Oc1ccc(-c2ccc(C#Cc3ccc(-c4ccc(OC(=O)C(=C)CO)cc4)c(F)c3)c(CCCCCC=C(F)F)c2)cc1] |
| 1γ-6-45 | 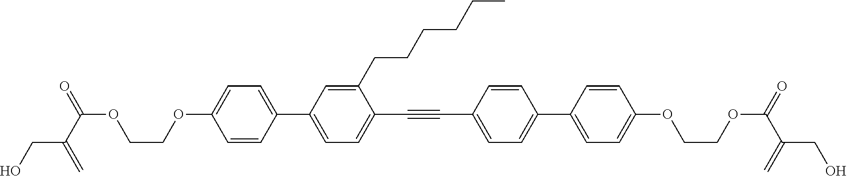 [SMILES: C=C(CO)C(=O)OCCOc1ccc(-c2ccc(C#Cc3ccc(-c4ccc(OCCOC(=O)C(=C)CO)cc4)cc3CCCCCC)cc2)cc1] |
| 1γ-6-46 | 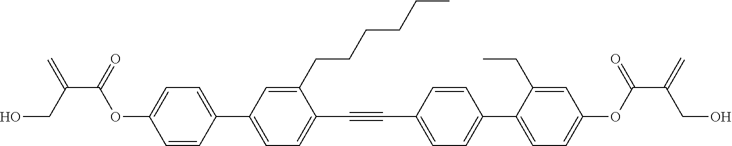 [SMILES: C=C(CO)C(=O)Oc1ccc(-c2ccc(C#Cc3ccc(-c4ccc(OC(=O)C(=C)CO)cc4CC)cc3)c(CCCCCC)c2)cc1] |
| 1γ-6-47 | 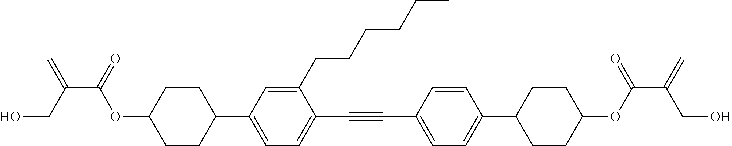 [SMILES: C=C(CO)C(=O)OC1CCC(c2ccc(C#Cc3ccc(C4CCC(OC(=O)C(=C)CO)CC4)cc3CCCCCC)cc2)CC1] |
| 1γ-6-48 | 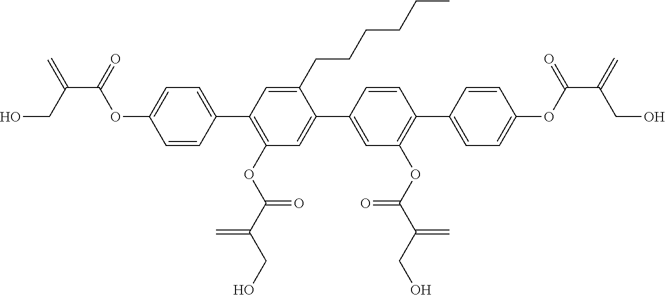 [SMILES: C=C(CO)C(=O)Oc1ccc(-c2ccc(-c3cc(OC(=O)C(=C)CO)c(-c4ccc(OC(=O)C(=C)CO)cc4)cc3CCCCCC)cc2OC(=O)C(=C)CO)cc1] |
| 1γ-6-49 | 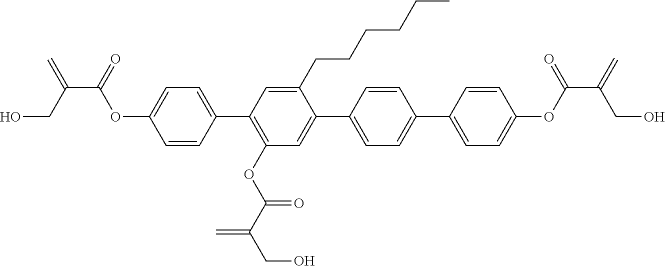 [SMILES: C=C(CO)C(=O)Oc1ccc(-c2ccc(-c3cc(OC(=O)C(=C)CO)c(-c4ccc(OC(=O)C(=C)CO)cc4)cc3CCCCCC)cc2)cc1] |
| 1γ-6-50 | 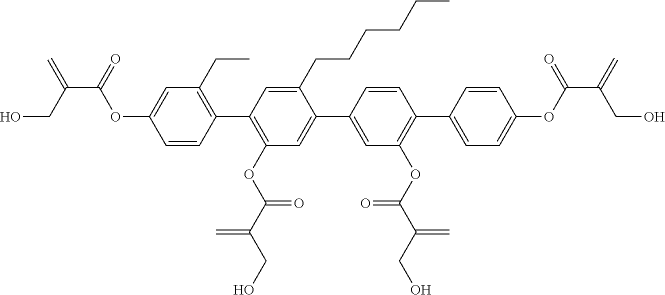 [SMILES: C=C(CO)C(=O)Oc1ccc(-c2ccc(-c3cc(OC(=O)C(=C)CO)c(-c4ccc(OC(=O)C(=C)CO)cc4CC)cc3CCCCCC)cc2OC(=O)C(=C)CO)cc1] |
| 1γ-6-51 | 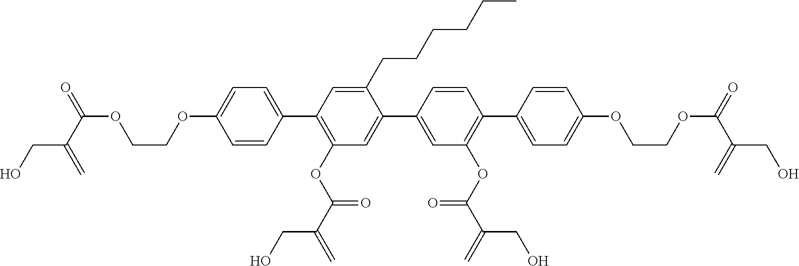 |
| 1γ-6-52 | 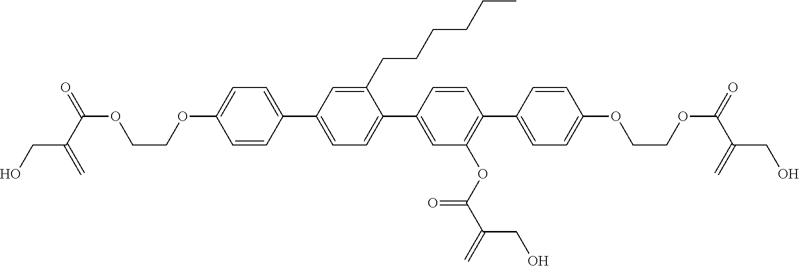 |
| 1γ-6-53 | 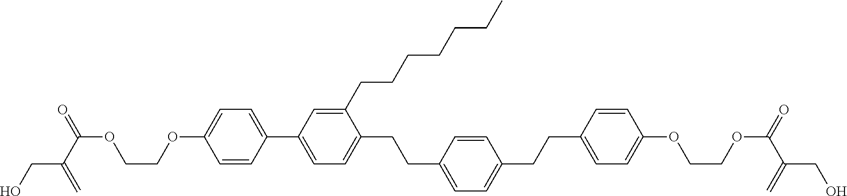 [SMILES: C=C(CO)C(=O)OCCOc1ccc(CCc2ccc(CCc3ccc(-c4ccc(OCCOC(=O)C(=C)CO)cc4)cc3CCCCCCC)cc2)cc1] |
| 1γ-6-54 | 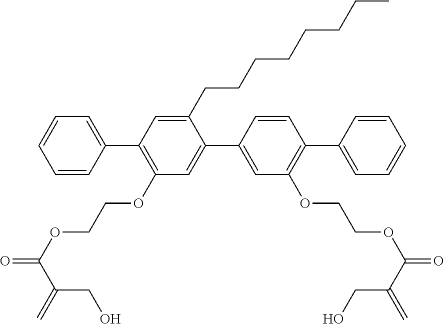 [SMILES: C=C(CO)C(=O)OCCOc1cc(-c2cc(OCCOC(=O)C(=C)CO)c(-c3ccccc3)cc2CCCCCCCC)ccc1-c1ccccc1] |
| 1γ-6-55 | 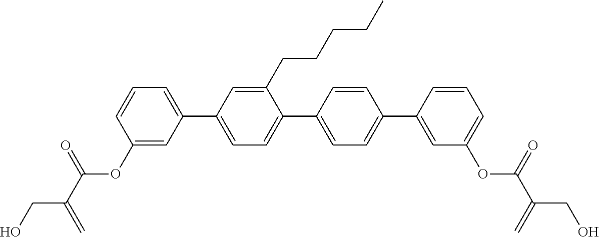 [SMILES: C=C(CO)C(=O)Oc1cccc(-c2ccc(-c3ccc(-c4cccc(OC(=O)C(=C)CO)c4)cc3CCCCC)cc2)c1] |
| 1γ-6-56 | 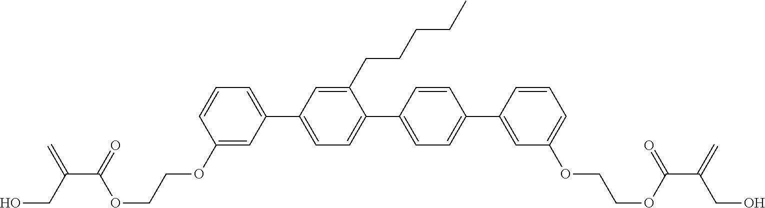 [SMILES: C=C(CO)C(=O)OCCOc1cccc(-c2ccc(-c3ccc(-c4cccc(OCCOC(=O)C(=C)CO)c4)cc3CCCCC)cc2)c1] |
| 1γ-6-57 | 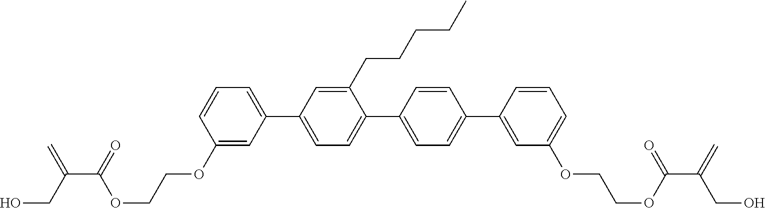 [SMILES: C=C(CO)C(=O)OCCOc1cccc(-c2ccc(-c3ccc(-c4cccc(OCCOC(=O)C(=C)CO)c4)cc3CCCCC)cc2)c1] |
| 1γ-6-58 | 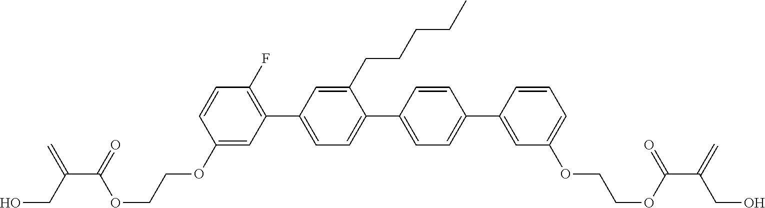 [SMILES: C=C(CO)C(=O)OCCOc1cccc(-c2ccc(-c3ccc(-c4cc(OCCOC(=O)C(=C)CO)ccc4F)cc3CCCCC)cc2)c1] |
| 1γ-6-59 | 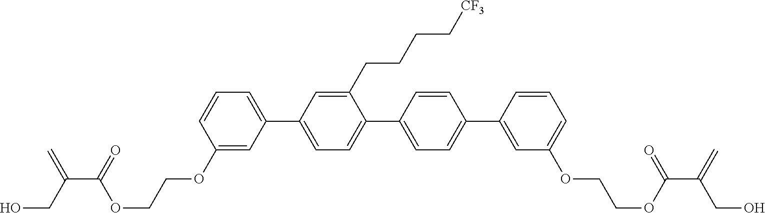 [SMILES: C=C(CO)C(=O)OCCOc1cccc(-c2ccc(-c3ccc(-c4cccc(OCCOC(=O)C(=C)CO)c4)cc3CCCCC(F)(F)F)cc2)c1] |
| 1γ-6-60 | 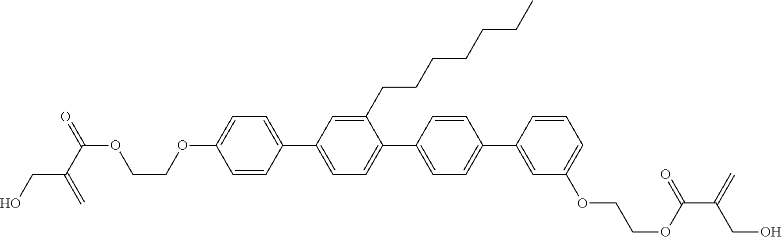 [SMILES: C=C(CO)C(=O)OCCOc1ccc(-c2ccc(-c3ccc(-c4cccc(OCCOC(=O)C(=C)CO)c4)cc3)c(CCCCCCC)c2)cc1] |

### 17. Example of Compound (1δ)

According to the synthesis methods described in Synthesis Examples, compounds (1δ-1-1) to (1δ-1-13) shown below can be prepared.

| No. | |
|---|---|
| 1δ-1-1 | 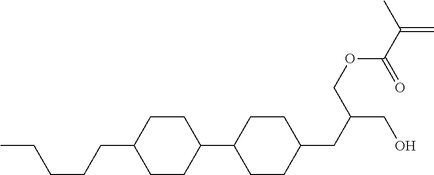 [SMILES: C=C(C)C(=O)OCC(CO)CC1CCC(C2CCC(CCCCC)CC2)CC1] |
| 1δ-1-2 | 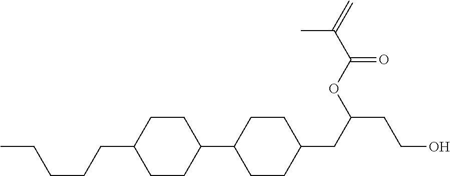 [SMILES: C=C(C)C(=O)OC(CCO)CC1CCC(C2CCC(CCCCC)CC2)CC1] |
| 1δ-1-3 | 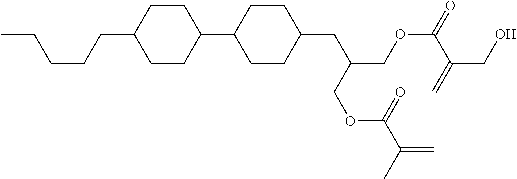 [SMILES: C=C(C)C(=O)OCC(COC(=O)C(=C)CO)CC1CCC(C2CCC(CCCCC)CC2)CC1] |
| 1δ-1-4 | 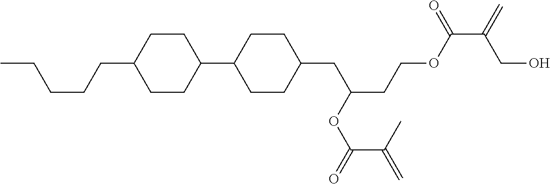 [SMILES: C=C(C)C(=O)OC(CCOC(=O)C(=C)CO)CC1CCC(C2CCC(CCCCC)CC2)CC1] |
| 1δ-1-5 | 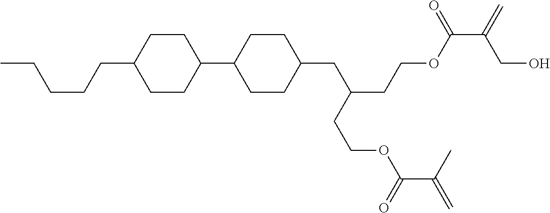 [SMILES: C=C(C)C(=O)OCCC(CCOC(=O)C(=C)CO)CC1CCC(C2CCC(CCCCC)CC2)CC1] |
| 1δ-1-6 | 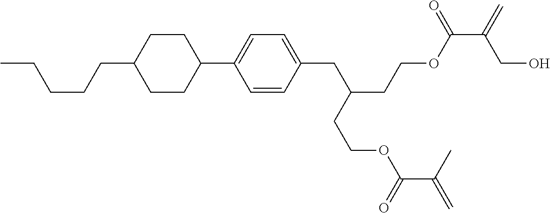 [SMILES: C=C(C)C(=O)OCCC(CCOC(=O)C(=C)CO)Cc1ccc(C2CCC(CCCCC)CC2)cc1] |
| 1δ-1-7 | 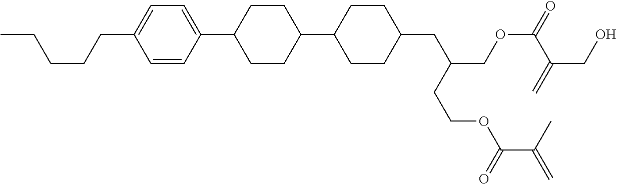 [SMILES: C=C(C)C(=O)OCCC(COC(=O)C(=C)CO)CC1CCC(C2CCC(c3ccc(CCCCC)cc3)CC2)CC1] |
| 1δ-1-8 | 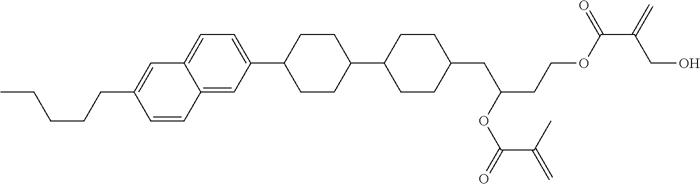 [SMILES: C=C(C)C(=O)OC(CCOC(=O)C(=C)CO)CC1CCC(C2CCC(c3ccc4cc(CCCCC)ccc4c3)CC2)CC1] |
| 1δ-1-9 | 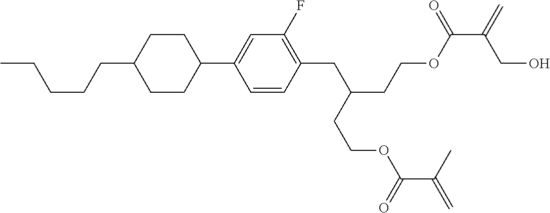 [SMILES: C=C(C)C(=O)OCCC(CCOC(=O)C(=C)CO)Cc1ccc(C2CCC(CCCCC)CC2)cc1F] |
| 1δ-1-10 | 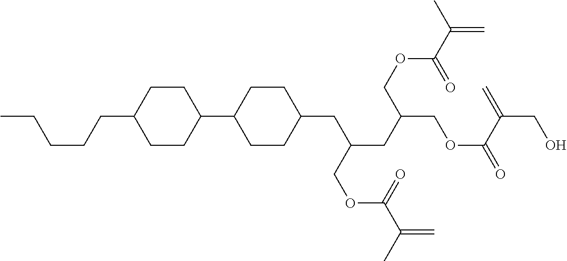 [SMILES: C=C(C)C(=O)OCC(COC(=O)C(=C)CO)CC(COC(=O)C(=C)C)CC1CCC(C2CCC(CCCCC)CC2)CC1] |
| 1δ-1-11 | 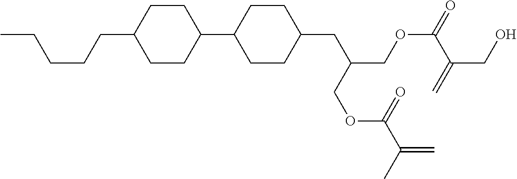 [SMILES: C=C(C)C(=O)OCC(COC(=O)C(=C)CO)CC1CCC(C2CCC(CCCCC)CC2)CC1] |
| 1δ-1-12 | 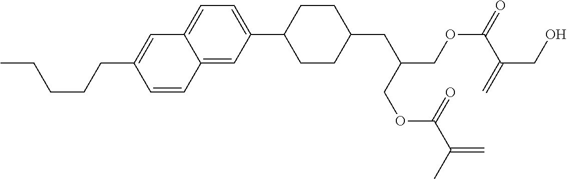 [SMILES: C=C(C)C(=O)OCC(COC(=O)C(=C)CO)CC1CCC(c2ccc3cc(CCCCC)ccc3c2)CC1] |
| 1δ-1-13 | 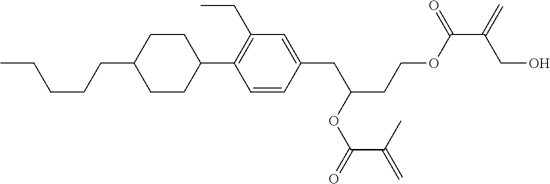 [SMILES: C=C(C)C(=O)OC(CCOC(=O)C(=C)CO)Cc1ccc(C2CCC(CCCCC)CC2)c(CC)c1] |

### 18. Example of Compound (1ε)

According to the synthesis methods described in Synthesis Examples, compounds (1ε-1-1) to (1ε-1-20), compounds (1ε-2-1) to (1ε-2-180), compounds (1ε-3-1) to (1ε-3-140), compounds (1ε-4-1) to (1ε-4-134) and (1ε-5-1) to (1ε-5-20), compounds (1ε-6-1) to (1ε-6-180), compounds (1ε-7-1) to (1ε-7-140), compounds (1ε-8-1) to (1ε-8-134), compounds (1ε-9-1) to (1ε-9-40), compounds (1ε-10-1) to (1ε-10-200), compounds (1ε-11-1) to (1ε-11-140) and compounds (1ε-12-1) to (1ε-12-100) shown below can be prepared.

| No. | |
|---|---|
| 1ϵ-1-1 | 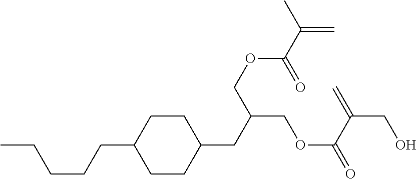 [SMILES: C=C(C)C(=O)OCC(COC(=O)C(=C)CO)CC1CCC(CCCCC)CC1] |
| 1ϵ-1-2 | 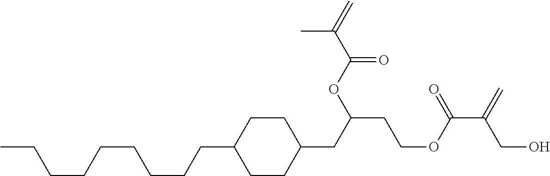 [SMILES: C=C(C)C(=O)OC(CCOC(=O)C(=C)CO)CC1CCC(CCCCCCCCC)CC1] |
| 1ϵ-1-3 | 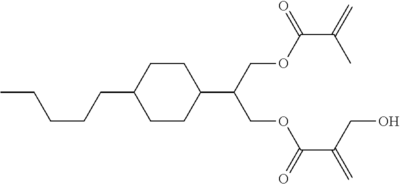 [SMILES: C=C(C)C(=O)OCC(COC(=O)C(=C)CO)C1CCC(CCCCC)CC1] |
| 1ϵ-1-4 | 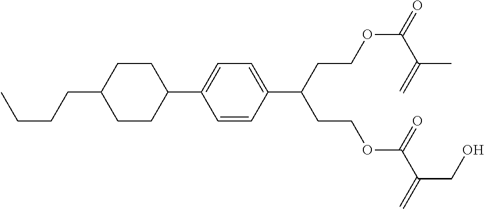 [SMILES: C=C(C)C(=O)OCCC(CCOC(=O)C(=C)CO)c1ccc(C2CCC(CCCC)CC2)cc1] |
| 1ϵ-1-5 | 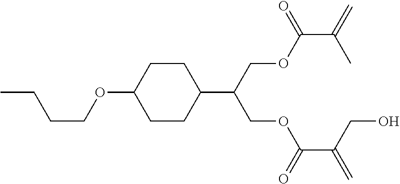 [SMILES: C=C(C)C(=O)OCC(COC(=O)C(=C)CO)C1CCC(OCCCC)CC1] |
| 1ϵ-1-6 | 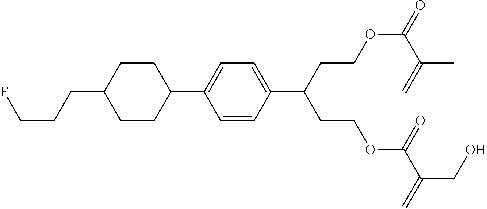 [SMILES: C=C(C)C(=O)OCCC(CCOC(=O)C(=C)CO)c1ccc(C2CCC(CCCF)CC2)cc1] |
| 1ϵ-1-7 | 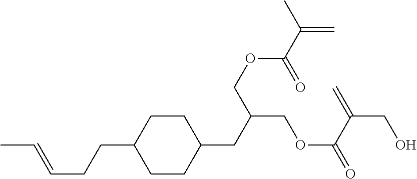 [SMILES: C=C(C)C(=O)OCC(COC(=O)C(=C)CO)CC1CCC(CC/C=C/C)CC1] |
| 1ϵ-1-8 | 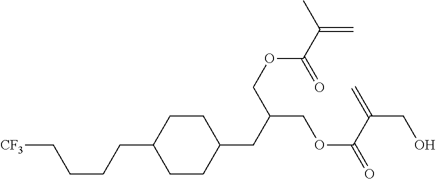 [SMILES: C=C(C)C(=O)OCC(COC(=O)C(=C)CO)CC1CCC(CCCCC(F)(F)F)CC1] |
| 1ϵ-1-9 | 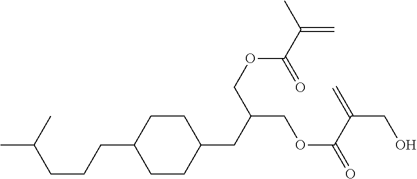 [SMILES: C=C(C)C(=O)OCC(COC(=O)C(=C)CO)CC1CCC(CCCC(C)C)CC1] |
| 1ϵ-1-10 | 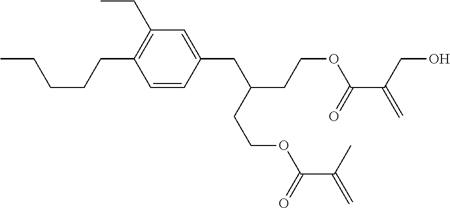 [SMILES: C=C(C)C(=O)OCCC(CCOC(=O)C(=C)CO)Cc1ccc(CCCCC)c(CC)c1] |
| 1ϵ-1-11 | 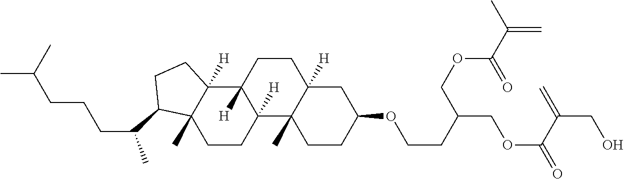 |
| 1ϵ-1-12 | 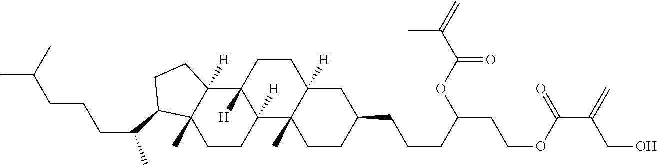 |
| 1ϵ-1-13 | 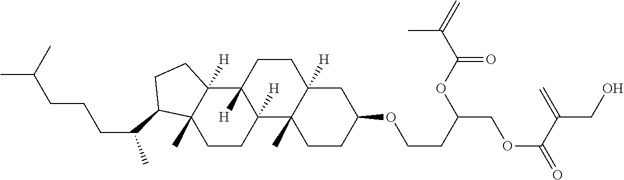 |
| 1ϵ-1-14 | 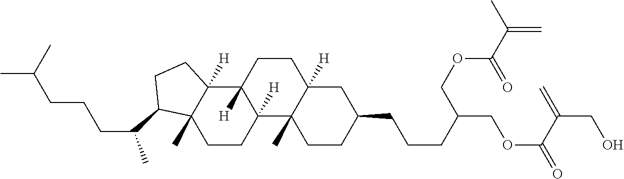 |
| 1ϵ-1-15 | 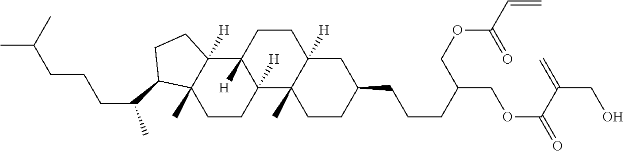 |
| 1ϵ-1-16 | 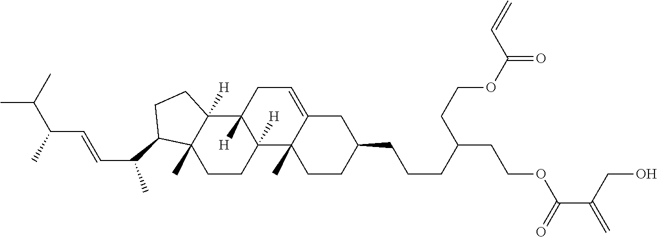 |
| 1ϵ-1-17 | 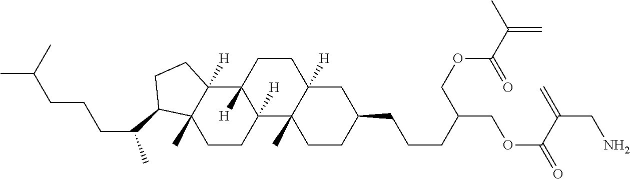 |
| 1ϵ-1-18 | 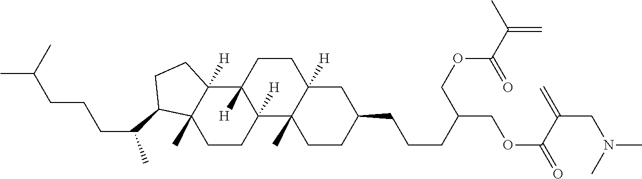 |
| 1ϵ-1-19 | 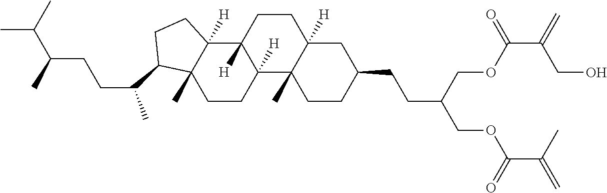 |
| 1ϵ-1-20 | 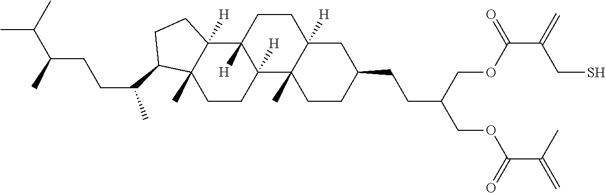 |
| 1ϵ-2-1 | 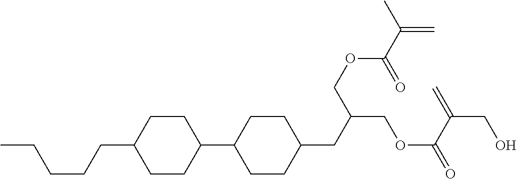 [SMILES: C=C(C)C(=O)OCC(COC(=O)C(=C)CO)CC1CCC(C2CCC(CCCCC)CC2)CC1] |
| 1ϵ-2-2 | 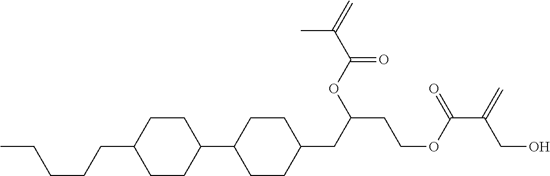 [SMILES: C=C(C)C(=O)OC(CCOC(=O)C(=C)CO)CC1CCC(C2CCC(CCCCC)CC2)CC1] |
| 1ϵ-2-3 | 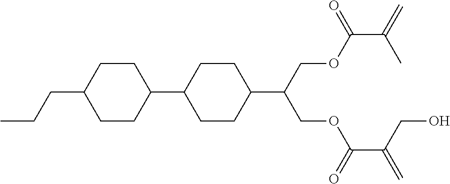 [SMILES: C=C(C)C(=O)OCC(COC(=O)C(=C)CO)C1CCC(C2CCC(CCC)CC2)CC1] |
| 1ϵ-2-4 | 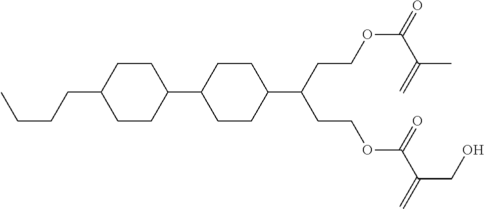 [SMILES: C=C(C)C(=O)OCCC(CCOC(=O)C(=C)CO)C1CCC(C2CCC(CCCC)CC2)CC1] |
| 1ϵ-2-5 | 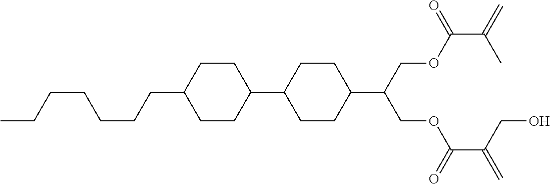 [SMILES: C=C(C)C(=O)OCC(COC(=O)C(=C)CO)C1CCC(C2CCC(CCCCCCC)CC2)CC1] |
| 1ϵ-2-6 | 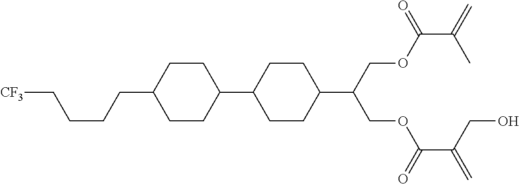 [SMILES: C=C(C)C(=O)OCC(COC(=O)C(=C)CO)C1CCC(C2CCC(CCCCC(F)(F)F)CC2)CC1] |
| 1ϵ-2-7 | 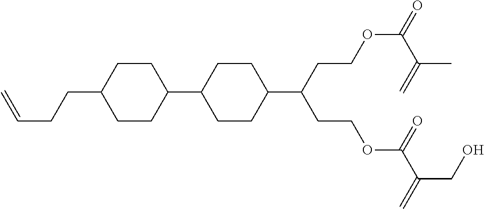 [SMILES: C=CCCC1CCC(C2CCC(C(CCOC(=O)C(=C)C)CCOC(=O)C(=C)CO)CC2)CC1] |
| 1ϵ-2-8 | 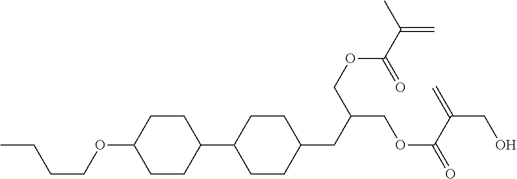 [SMILES: C=C(C)C(=O)OCC(COC(=O)C(=C)CO)CC1CCC(C2CCC(OCCCC)CC2)CC1] |
| 1ϵ-2-9 | 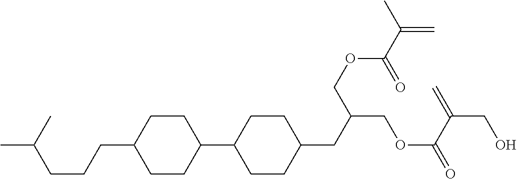 [SMILES: C=C(C)C(=O)OCC(COC(=O)C(=C)CO)CC1CCC(C2CCC(CCCC(C)C)CC2)CC1] |
| 1ϵ-2-10 | 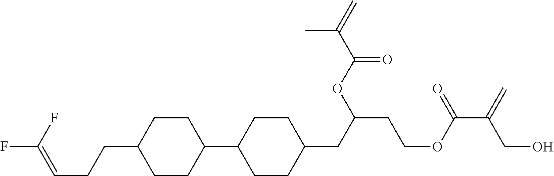 [SMILES: C=C(C)C(=O)OC(CCOC(=O)C(=C)CO)CC1CCC(C2CCC(CCC=C(F)F)CC2)CC1] |
| 1ϵ-2-11 | 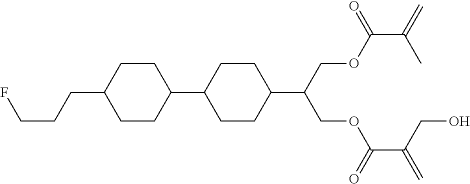 [SMILES: C=C(C)C(=O)OCC(COC(=O)C(=C)CO)C1CCC(C2CCC(CCCF)CC2)CC1] |
| 1ϵ-2-12 | 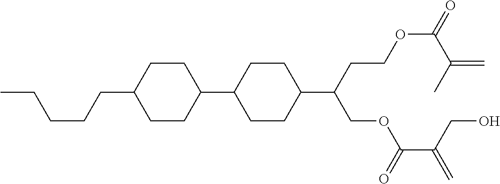 [SMILES: C=C(C)C(=O)OCCC(COC(=O)C(=C)CO)C1CCC(C2CCC(CCCCC)CC2)CC1] |
| 1ϵ-2-13 | 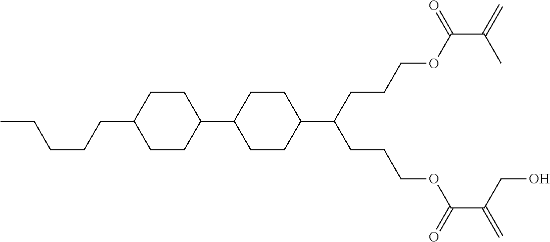 [SMILES: C=C(C)C(=O)OCCCC(CCCOC(=O)C(=C)CO)C1CCC(C2CCC(CCCCC)CC2)CC1] |
| 1ϵ-2-14 | 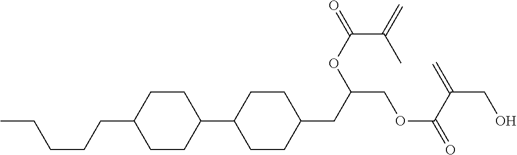 [SMILES: C=C(C)C(=O)OC(COC(=O)C(=C)CO)CC1CCC(C2CCC(CCCCC)CC2)CC1] |
| 1ϵ-2-15 | 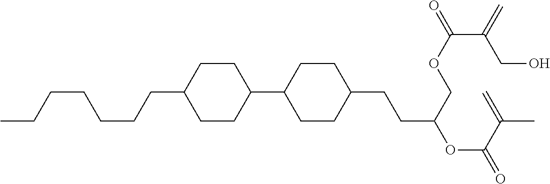 [SMILES: C=C(C)C(=O)OC(CCC1CCC(C2CCC(CCCCCCC)CC2)CC1)COC(=O)C(=C)CO] |
| 1ϵ-2-16 | 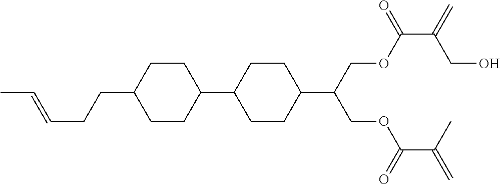 [SMILES: C=C(C)C(=O)OCC(COC(=O)C(=C)CO)C1CCC(C2CCC(CC/C=C/C)CC2)CC1] |
| 1ϵ-2-17 | 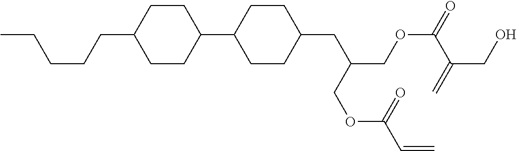 [SMILES: C=CC(=O)OCC(COC(=O)C(=C)CO)CC1CCC(C2CCC(CCCCC)CC2)CC1] |
| 1ϵ-2-18 | 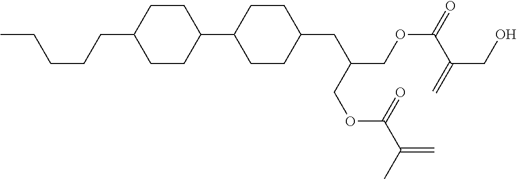 [SMILES: C=C(C)C(=O)OCC(COC(=O)C(=C)CO)CC1CCC(C2CCC(CCCCC)CC2)CC1] |
| 1ϵ-2-19 | 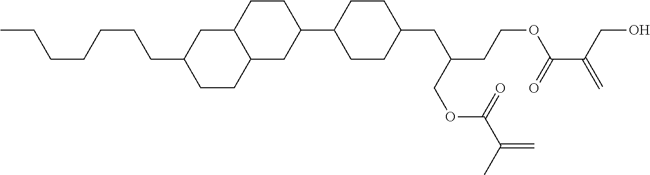 [SMILES: C=C(C)C(=O)OCC(CCOC(=O)C(=C)CO)CC1CCC(C2CCC3CC(CCCCCCC)CCC3C2)CC1] |
| 1ϵ-2-20 | 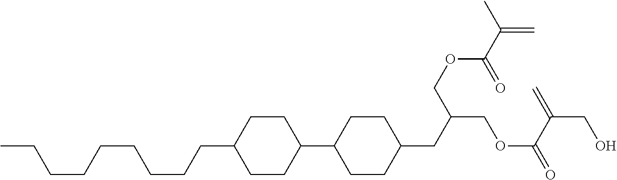 [SMILES: C=C(C)C(=O)OCC(COC(=O)C(=C)CO)CC1CCC(C2CCC(CCCCCCCCC)CC2)CC1] |
| 1ϵ-2-21 | 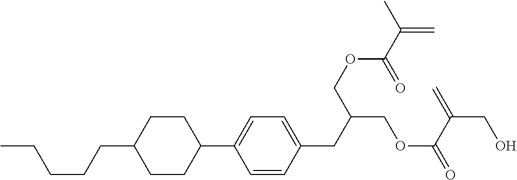 [SMILES: C=C(C)C(=O)OCC(COC(=O)C(=C)CO)Cc1ccc(C2CCC(CCCCC)CC2)cc1] |
| 1ϵ-2-22 | 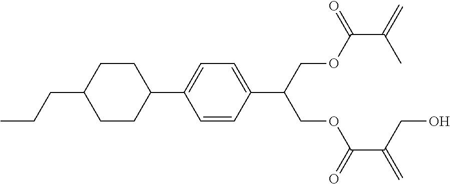 [SMILES: C=C(C)C(=O)OCC(COC(=O)C(=C)CO)c1ccc(C2CCC(CCC)CC2)cc1] |
| 1ϵ-2-23 | 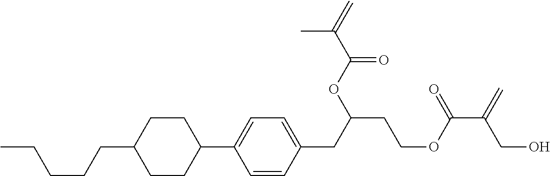 [SMILES: C=C(C)C(=O)OC(CCOC(=O)C(=C)CO)Cc1ccc(C2CCC(CCCCC)CC2)cc1] |
| 1ϵ-2-24 | 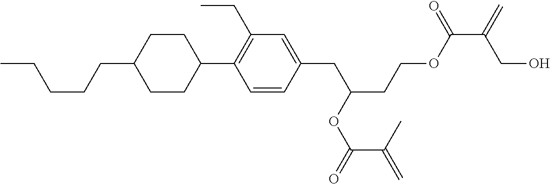 [SMILES: C=C(C)C(=O)OC(CCOC(=O)C(=C)CO)Cc1ccc(C2CCC(CCCCC)CC2)c(CC)c1] |
| 1ϵ-2-25 | 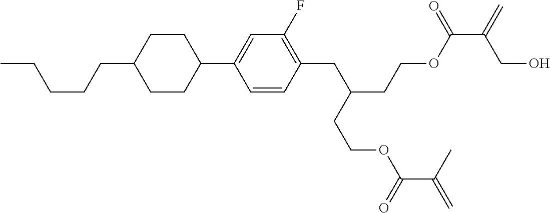 [SMILES: C=C(C)C(=O)OCCC(CCOC(=O)C(=C)CO)Cc1ccc(C2CCC(CCCCC)CC2)cc1F] |
| 1ϵ-2-26 | 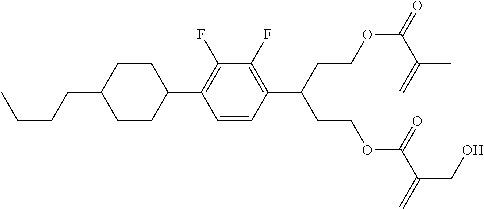 [SMILES: C=C(C)C(=O)OCCC(CCOC(=O)C(=C)CO)c1ccc(C2CCC(CCCC)CC2)c(F)c1F] |
| 1ϵ-2-27 | 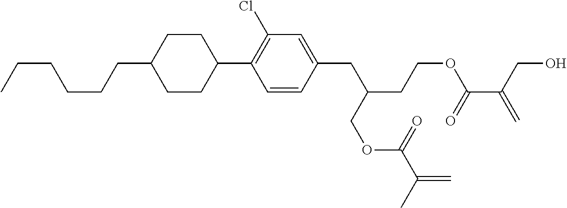 [SMILES: C=C(C)C(=O)OCC(CCOC(=O)C(=C)CO)Cc1ccc(C2CCC(CCCCCC)CC2)c(Cl)c1] |
| 1ϵ-2-28 | 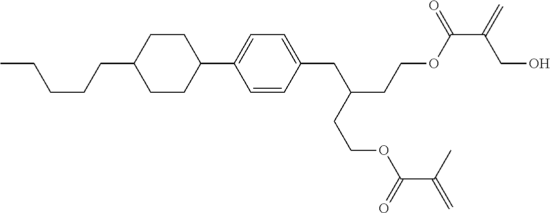 [SMILES: C=C(C)C(=O)OCCC(CCOC(=O)C(=C)CO)Cc1ccc(C2CCC(CCCCC)CC2)cc1] |
| 1ϵ-2-29 | 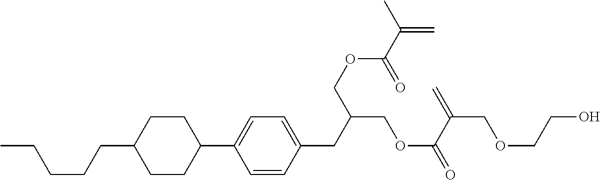 [SMILES: C=C(C)C(=O)OCC(COC(=O)C(=C)COCCO)Cc1ccc(C2CCC(CCCCC)CC2)cc1] |
| 1ϵ-2-30 | 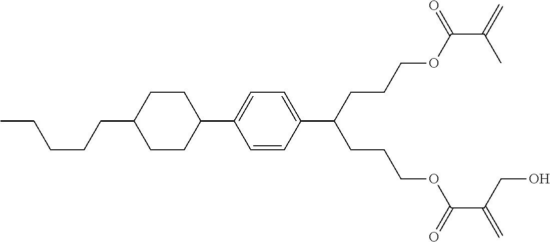 [SMILES: C=C(C)C(=O)OCCCC(CCCOC(=O)C(=C)CO)c1ccc(C2CCC(CCCCC)CC2)cc1] |
| 1ϵ-2-31 | 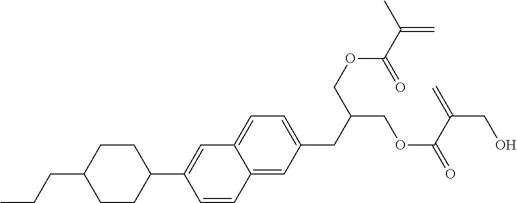 [SMILES: C=C(C)C(=O)OCC(COC(=O)C(=C)CO)Cc1ccc2cc(C3CCC(CCC)CC3)ccc2c1] |
| 1ϵ-2-32 | 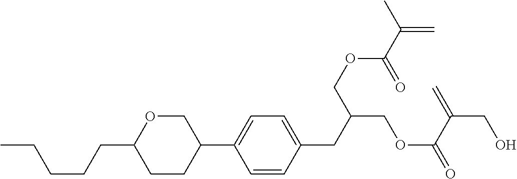 [SMILES: C=C(C)C(=O)OCC(COC(=O)C(=C)CO)Cc1ccc(C2CCC(CCCCC)OC2)cc1] |
| 1ϵ-2-33 | 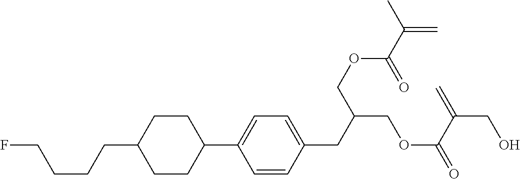 [SMILES: C=C(C)C(=O)OCC(COC(=O)C(=C)CO)Cc1ccc(C2CCC(CCCCF)CC2)cc1] |
| 1ϵ-2-34 | 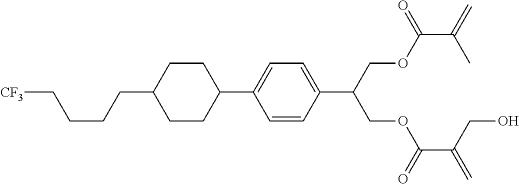 [SMILES: C=C(C)C(=O)OCC(COC(=O)C(=C)CO)c1ccc(C2CCC(CCCCC(F)(F)F)CC2)cc1] |
| 1ϵ-2-35 | 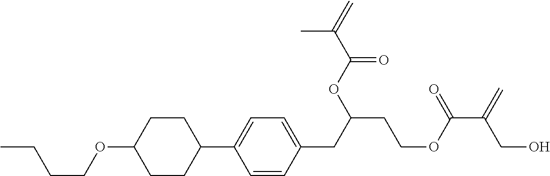 [SMILES: C=C(C)C(=O)OC(CCOC(=O)C(=C)CO)Cc1ccc(C2CCC(OCCCC)CC2)cc1] |
| 1ϵ-2-36 | 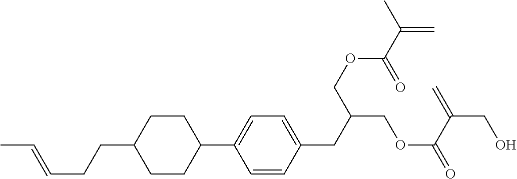 [SMILES: C=C(C)C(=O)OCC(COC(=O)C(=C)CO)Cc1ccc(C2CCC(CC/C=C/C)CC2)cc1] |
| 1ϵ-2-37 | 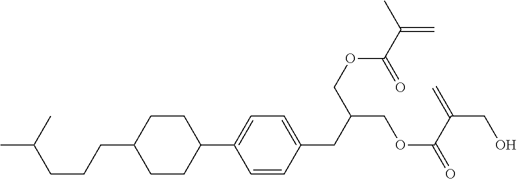 [SMILES: C=C(C)C(=O)OCC(COC(=O)C(=C)CO)Cc1ccc(C2CCC(CCCC(C)C)CC2)cc1] |
| 1ϵ-2-38 | 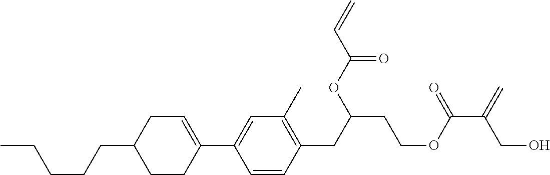 [SMILES: C=CC(=O)OC(CCOC(=O)C(=C)CO)Cc1ccc(C2=CCC(CCCCC)CC2)cc1C] |
| 1ϵ-2-39 | 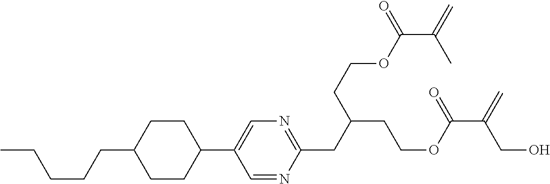 [SMILES: C=C(C)C(=O)OCCC(CCOC(=O)C(=C)CO)Cc1ncc(C2CCC(CCCCC)CC2)cn1] |
| 1ϵ-2-40 | 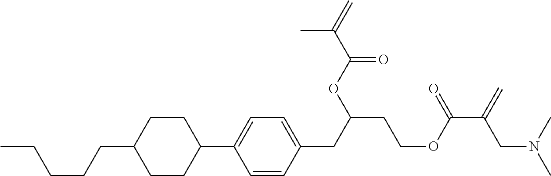 [SMILES: C=C(C)C(=O)OC(CCOC(=O)C(=C)CN(C)C)Cc1ccc(C2CCC(CCCCC)CC2)cc1] |
| 1ϵ-2-41 | 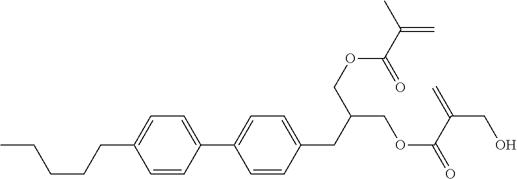 [SMILES: C=C(C)C(=O)OCC(COC(=O)C(=C)CO)Cc1ccc(-c2ccc(CCCCC)cc2)cc1] |
| 1ϵ-2-42 | 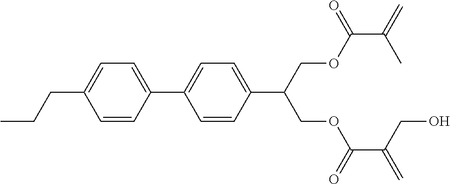 [SMILES: C=C(C)C(=O)OCC(COC(=O)C(=C)CO)c1ccc(-c2ccc(CCC)cc2)cc1] |
| 1ϵ-2-43 | 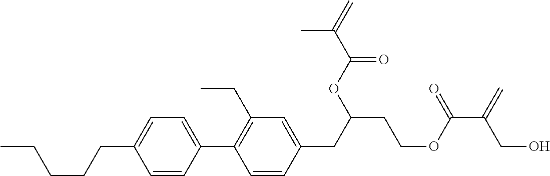 [SMILES: C=C(C)C(=O)OC(CCOC(=O)C(=C)CO)Cc1ccc(-c2ccc(CCCCC)cc2)c(CC)c1] |
| 1ϵ-2-44 | 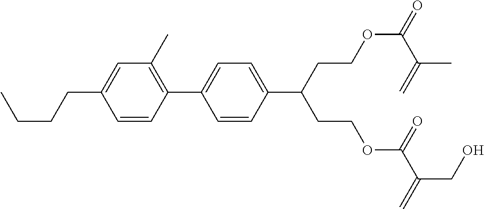 [SMILES: C=C(C)C(=O)OCCC(CCOC(=O)C(=C)CO)c1ccc(-c2ccc(CCCC)cc2C)cc1] |
| 1ϵ-2-45 | 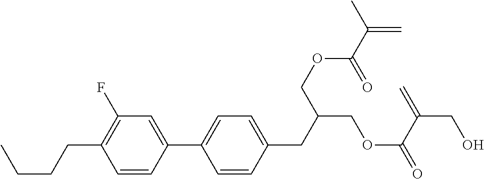 [SMILES: C=C(C)C(=O)OCC(COC(=O)C(=C)CO)Cc1ccc(-c2ccc(CCCC)c(F)c2)cc1] |
| 1ϵ-2-46 | 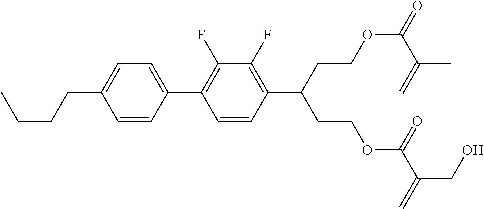 [SMILES: C=C(C)C(=O)OCCC(CCOC(=O)C(=C)CO)c1ccc(-c2ccc(CCCC)cc2)c(F)c1F] |
| 1ϵ-2-47 | 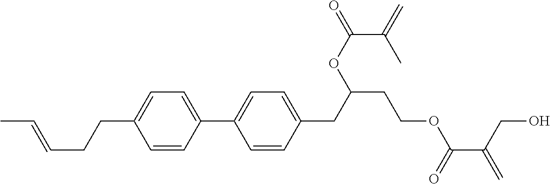 [SMILES: C=C(C)C(=O)OC(CCOC(=O)C(=C)CO)Cc1ccc(-c2ccc(CC/C=C/C)cc2)cc1] |
| 1ϵ-2-48 | 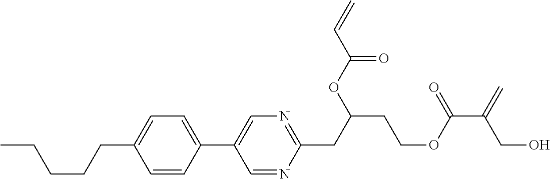 [SMILES: C=CC(=O)OC(CCOC(=O)C(=C)CO)Cc1ncc(-c2ccc(CCCCC)cc2)cn1] |
| 1ϵ-2-49 | 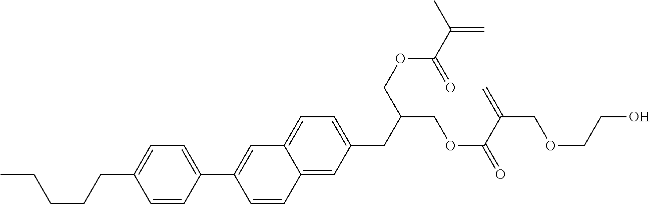 [SMILES: C=C(C)C(=O)OCC(COC(=O)C(=C)COCCO)Cc1ccc2cc(-c3ccc(CCCCC)cc3)ccc2c1] |
| 1ϵ-2-50 | 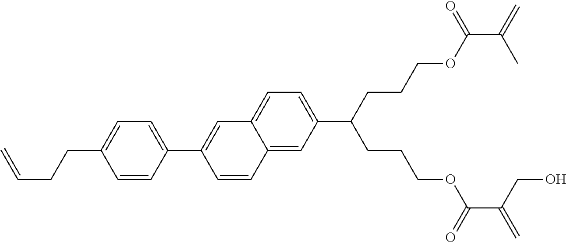 [SMILES: C=CCCc1ccc(-c2ccc3cc(C(CCCOC(=O)C(=C)C)CCCOC(=O)C(=C)CO)ccc3c2)cc1] |
| 1ϵ-2-51 | 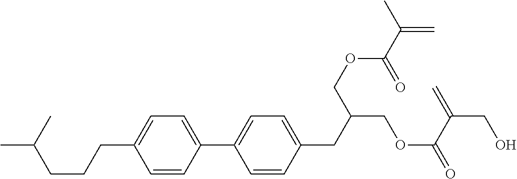 [SMILES: C=C(C)C(=O)OCC(COC(=O)C(=C)CO)Cc1ccc(-c2ccc(CCCC(C)C)cc2)cc1] |
| 1ϵ-2-52 | 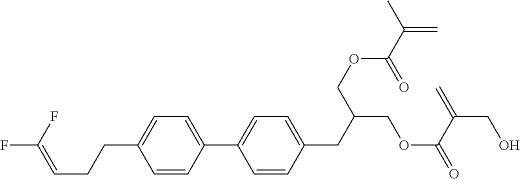 [SMILES: C=C(C)C(=O)OCC(COC(=O)C(=C)CO)Cc1ccc(-c2ccc(CCC=C(F)F)cc2)cc1] |
| 1ϵ-2-53 | 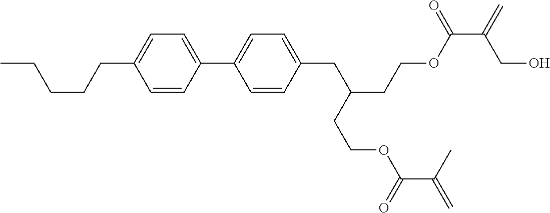 [SMILES: C=C(C)C(=O)OCCC(CCOC(=O)C(=C)CO)Cc1ccc(-c2ccc(CCCCC)cc2)cc1] |
| 1ϵ-2-54 | 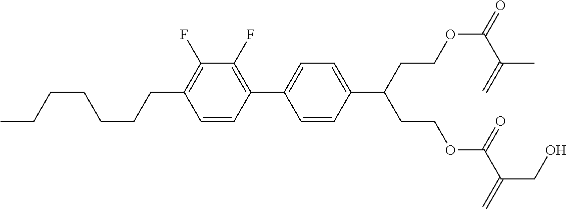 [SMILES: C=C(C)C(=O)OCCC(CCOC(=O)C(=C)CO)c1ccc(-c2ccc(CCCCCCC)c(F)c2F)cc1] |
| 1ϵ-2-55 | 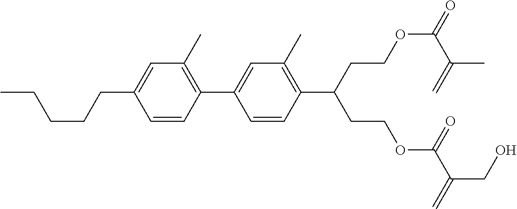 [SMILES: C=C(C)C(=O)OCCC(CCOC(=O)C(=C)CO)c1ccc(-c2ccc(CCCCC)cc2C)cc1C] |
| 1ϵ-2-56 | 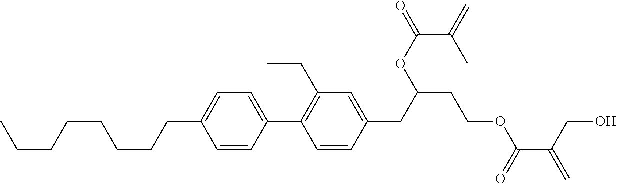 [SMILES: C=C(C)C(=O)OC(CCOC(=O)C(=C)CO)Cc1ccc(-c2ccc(CCCCCCCC)cc2)c(CC)c1] |
| 1ϵ-2-57 | 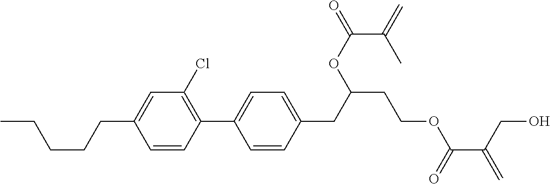 [SMILES: C=C(C)C(=O)OC(CCOC(=O)C(=C)CO)Cc1ccc(-c2ccc(CCCCC)cc2Cl)cc1] |
| 1ϵ-2-58 | 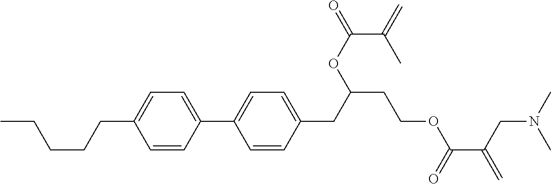 [SMILES: C=C(C)C(=O)OC(CCOC(=O)C(=C)CN(C)C)Cc1ccc(-c2ccc(CCCCC)cc2)cc1] |
| 1ϵ-2-59 | 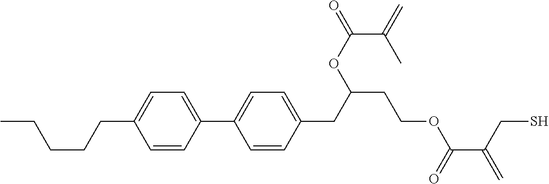 [SMILES: C=C(C)C(=O)OC(CCOC(=O)C(=C)CS)Cc1ccc(-c2ccc(CCCCC)cc2)cc1] |
| 1ϵ-2-60 | 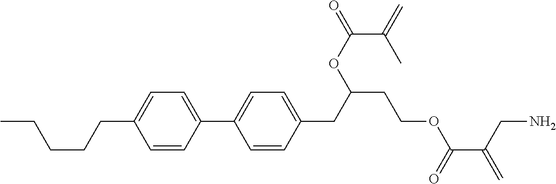 [SMILES: C=C(C)C(=O)OC(CCOC(=O)C(=C)CN)Cc1ccc(-c2ccc(CCCCC)cc2)cc1] |
| 1ϵ-2-61 | 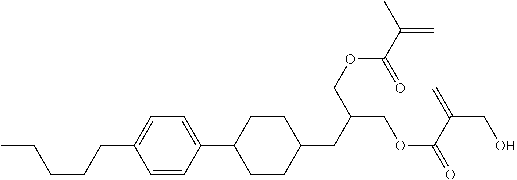 [SMILES: C=C(C)C(=O)OCC(COC(=O)C(=C)CO)CC1CCC(c2ccc(CCCCC)cc2)CC1] |
| 1ϵ-2-62 | 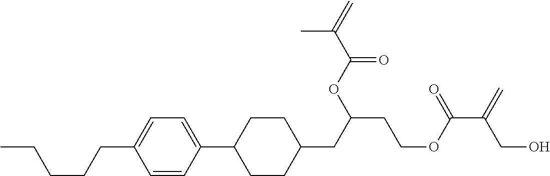 [SMILES: C=C(C)C(=O)OC(CCOC(=O)C(=C)CO)CC1CCC(c2ccc(CCCCC)cc2)CC1] |
| 1ϵ-2-63 | 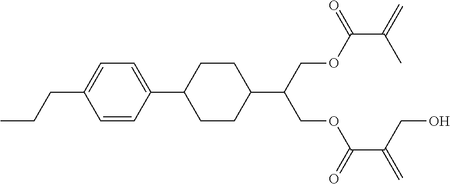 [SMILES: C=C(C)C(=O)OCC(COC(=O)C(=C)CO)C1CCC(c2ccc(CCC)cc2)CC1] |
| 1ϵ-2-64 | 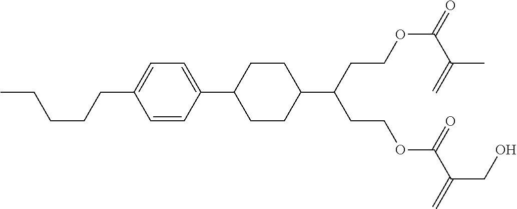 [SMILES: C=C(C)C(=O)OCCC(CCOC(=O)C(=C)CO)C1CCC(c2ccc(CCCCC)cc2)CC1] |
| 1ϵ-2-65 | 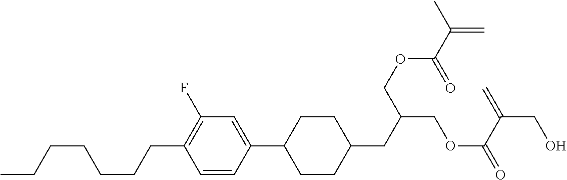 [SMILES: C=C(C)C(=O)OCC(COC(=O)C(=C)CO)CC1CCC(c2ccc(CCCCCCC)c(F)c2)CC1] |
| 1ϵ-2-66 | 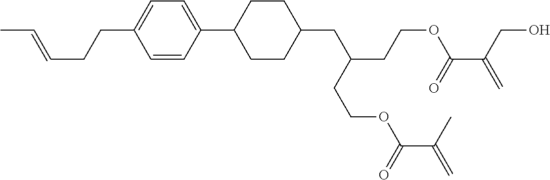 [SMILES: C=C(C)C(=O)OCCC(CCOC(=O)C(=C)CO)CC1CCC(c2ccc(CC/C=C/C)cc2)CC1] |
| 1ϵ-2-67 | 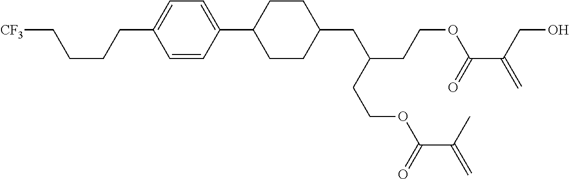 [SMILES: C=C(C)C(=O)OCCC(CCOC(=O)C(=C)CO)CC1CCC(c2ccc(CCCCC(F)(F)F)cc2)CC1] |
| 1ϵ-2-68 | 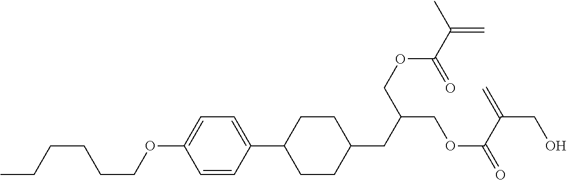 [SMILES: C=C(C)C(=O)OCC(COC(=O)C(=C)CO)CC1CCC(c2ccc(OCCCCCC)cc2)CC1] |
| 1ϵ-2-69 | 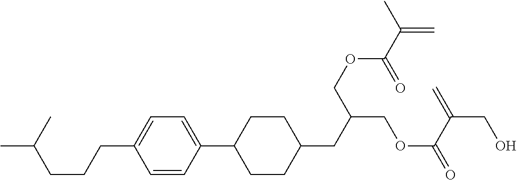 [SMILES: C=C(C)C(=O)OCC(COC(=O)C(=C)CO)CC1CCC(c2ccc(CCCC(C)C)cc2)CC1] |
| 1ϵ-2-70 | 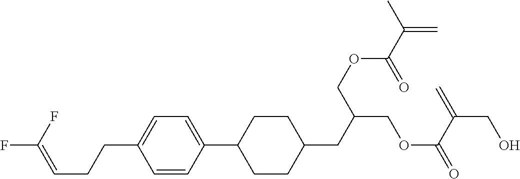 [SMILES: C=C(C)C(=O)OCC(COC(=O)C(=C)CO)CC1CCC(c2ccc(CCC=C(F)F)cc2)CC1] |
| 1ϵ-2-71 | 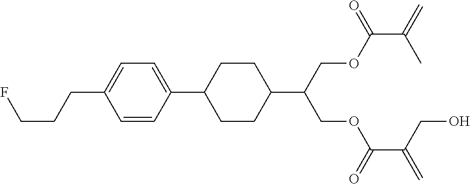 [SMILES: C=C(C)C(=O)OCC(COC(=O)C(=C)CO)C1CCC(c2ccc(CCCF)cc2)CC1] |
| 1ϵ-2-72 | 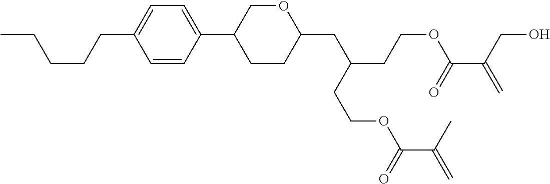 [SMILES: C=C(C)C(=O)OCCC(CCOC(=O)C(=C)CO)CC1CCC(c2ccc(CCCCC)cc2)CO1] |
| 1ϵ-2-73 | 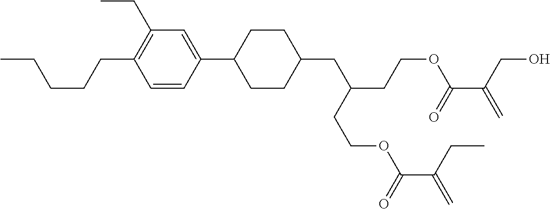 [SMILES: C=C(CC)C(=O)OCCC(CCOC(=O)C(=C)CO)CC1CCC(c2ccc(CCCCC)c(CC)c2)CC1] |
| 1ϵ-2-74 | 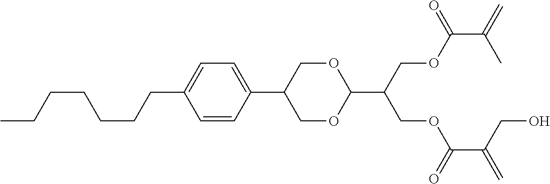 [SMILES: C=C(C)C(=O)OCC(COC(=O)C(=C)CO)C1OCC(c2ccc(CCCCCCC)cc2)CO1] |
| 1ϵ-2-75 | 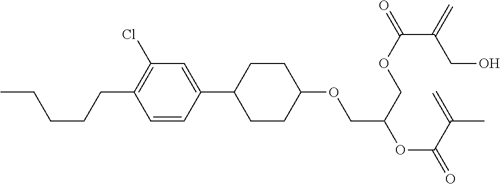 [SMILES: C=C(C)C(=O)OC(COC(=O)C(=C)CO)COC1CCC(c2ccc(CCCCC)c(Cl)c2)CC1] |
| 1ϵ-2-76 | 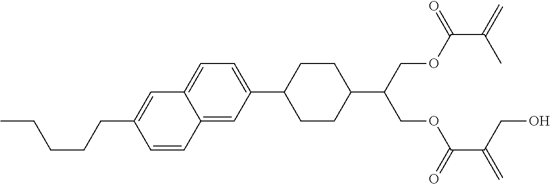 [SMILES: C=C(C)C(=O)OCC(COC(=O)C(=C)CO)C1CCC(c2ccc3cc(CCCCC)ccc3c2)CC1] |
| 1ϵ-2-77 | 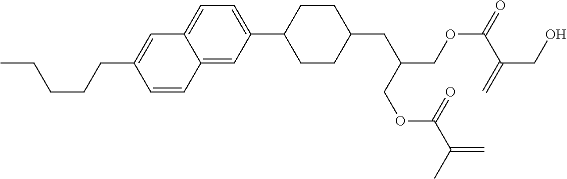 [SMILES: C=C(C)C(=O)OCC(COC(=O)C(=C)CO)CC1CCC(c2ccc3cc(CCCCC)ccc3c2)CC1] |
| 1ϵ-2-78 | 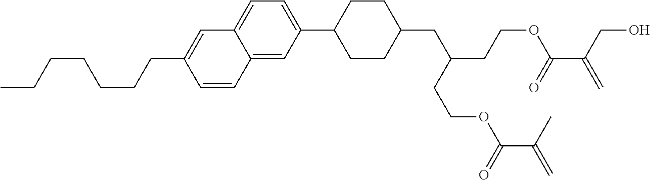 [SMILES: C=C(C)C(=O)OCCC(CCOC(=O)C(=C)CO)CC1CCC(c2ccc3cc(CCCCCCC)ccc3c2)CC1] |
| 1ϵ-2-79 | 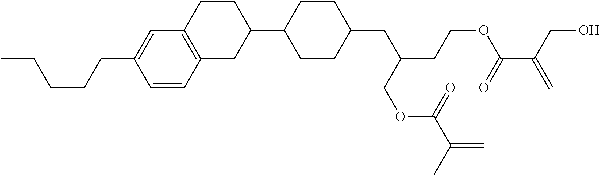 [SMILES: C=C(C)C(=O)OCC(CCOC(=O)C(=C)CO)CC1CCC(C2CCc3cc(CCCCC)ccc3C2)CC1] |
| 1ϵ-2-80 | 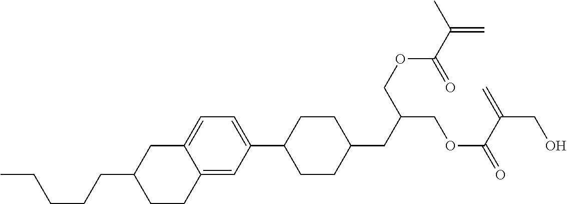 [SMILES: C=C(C)C(=O)OCC(COC(=O)C(=C)CO)CC1CCC(c2ccc3c(c2)CCC(CCCCC)C3)CC1] |
| 1ϵ-2-81 | 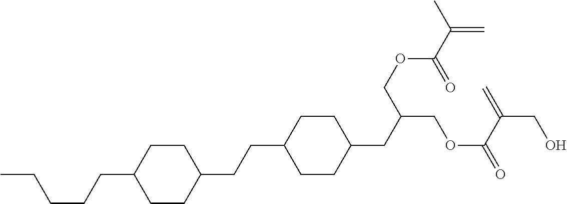 [SMILES: C=C(C)C(=O)OCC(COC(=O)C(=C)CO)CC1CCC(CCC2CCC(CCCCC)CC2)CC1] |
| 1ϵ-2-82 | 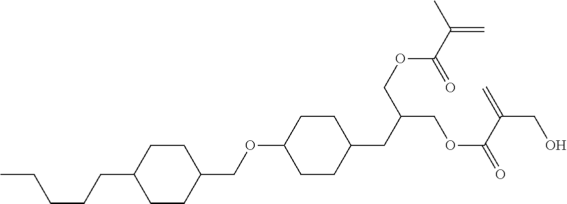 [SMILES: C=C(C)C(=O)OCC(COC(=O)C(=C)CO)CC1CCC(OCC2CCC(CCCCC)CC2)CC1] |
| 1ϵ-2-83 | 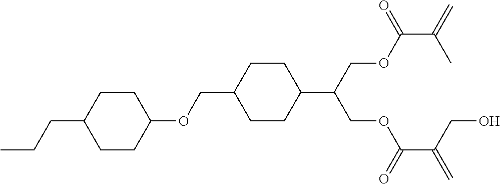 [SMILES: C=C(C)C(=O)OCC(COC(=O)C(=C)CO)C1CCC(COC2CCC(CCC)CC2)CC1] |
| 1ϵ-2-84 | 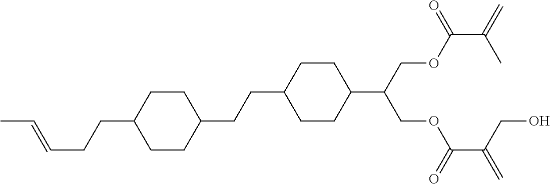 [SMILES: C=C(C)C(=O)OCC(COC(=O)C(=C)CO)C1CCC(CCC2CCC(CC/C=C/C)CC2)CC1] |
| 1ϵ-2-85 | 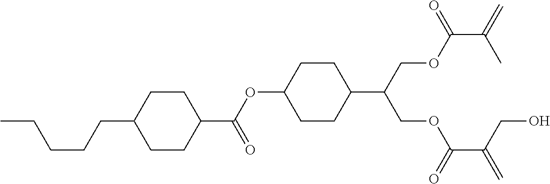 [SMILES: C=C(C)C(=O)OCC(COC(=O)C(=C)CO)C1CCC(OC(=O)C2CCC(CCCCC)CC2)CC1] |
| 1ϵ-2-86 | 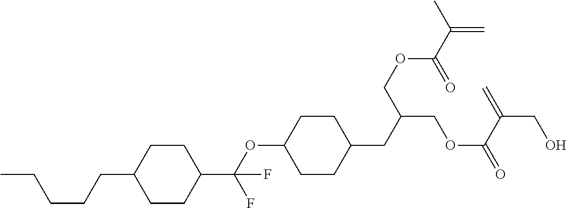 [SMILES: C=C(C)C(=O)OCC(COC(=O)C(=C)CO)CC1CCC(OC(F)(F)C2CCC(CCCCC)CC2)CC1] |
| 1ϵ-2-87 | 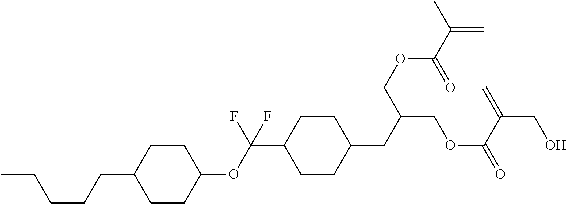 [SMILES: C=C(C)C(=O)OCC(COC(=O)C(=C)CO)CC1CCC(C(F)(F)OC2CCC(CCCCC)CC2)CC1] |
| 1ϵ-2-88 | 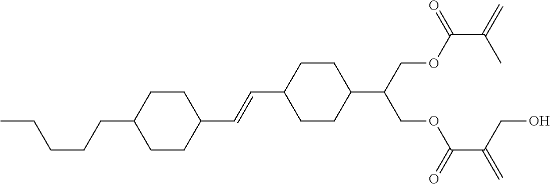 [SMILES: C=C(C)C(=O)OCC(COC(=O)C(=C)CO)C1CCC(/C=C/C2CCC(CCCCC)CC2)CC1] |
| 1ϵ-2-89 | 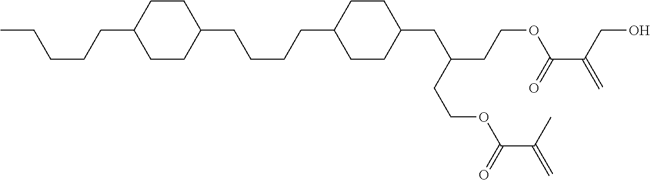 [SMILES: C=C(C)C(=O)OCCC(CCOC(=O)C(=C)CO)CC1CCC(CCCCC2CCC(CCCCC)CC2)CC1] |
| 1ϵ-2-90 | 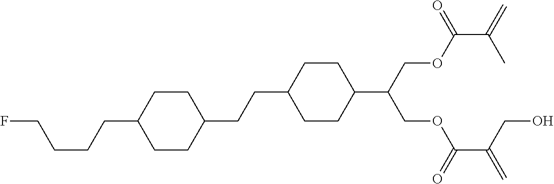 [SMILES: C=C(C)C(=O)OCC(COC(=O)C(=C)CO)C1CCC(CCC2CCC(CCCCF)CC2)CC1] |
| 1ϵ-2-91 | 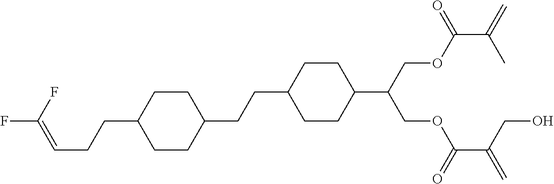 [SMILES: C=C(C)C(=O)OCC(COC(=O)C(=C)CO)C1CCC(CCC2CCC(CCC=C(F)F)CC2)CC1] |
| 1ϵ-2-92 | 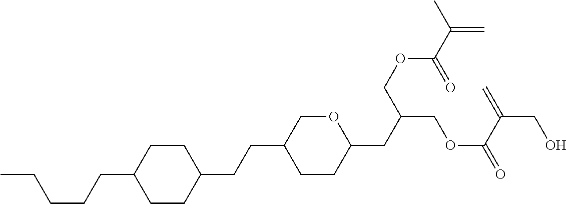 [SMILES: C=C(C)C(=O)OCC(COC(=O)C(=C)CO)CC1CCC(CCC2CCC(CCCCC)CC2)CO1] |
| 1ϵ-2-93 | 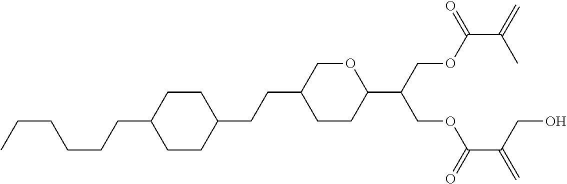 [SMILES: C=C(C)C(=O)OCC(COC(=O)C(=C)CO)C1CCC(CCC2CCC(CCCCCC)CC2)CO1] |
| 1ϵ-2-94 | 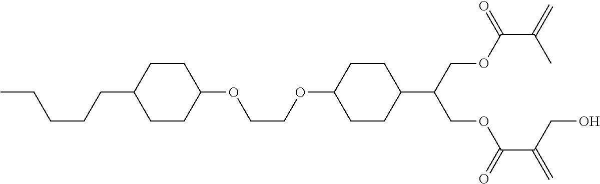 [SMILES: C=C(C)C(=O)OCC(COC(=O)C(=C)CO)C1CCC(OCCOC2CCC(CCCCC)CC2)CC1] |
| 1ϵ-2-95 | 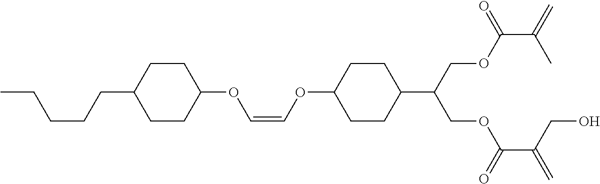 [SMILES: C=C(C)C(=O)OCC(COC(=O)C(=C)CO)C1CCC(O/C=C\OC2CCC(CCCCC)CC2)CC1] |
| 1ϵ-2-96 | 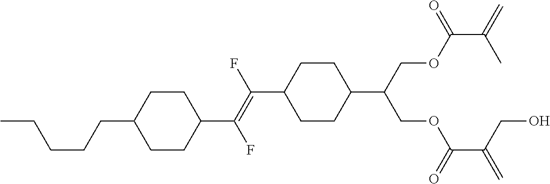 [SMILES: C=C(C)C(=O)OCC(COC(=O)C(=C)CO)C1CCC(/C(F)=C(\F)C2CCC(CCCCC)CC2)CC1] |
| 1ϵ-2-97 | 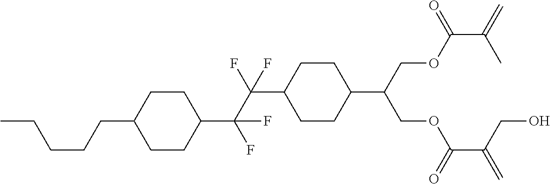 [SMILES: C=C(C)C(=O)OCC(COC(=O)C(=C)CO)C1CCC(C(F)(F)C(F)(F)C2CCC(CCCCC)CC2)CC1] |
| 1ϵ-2-98 | 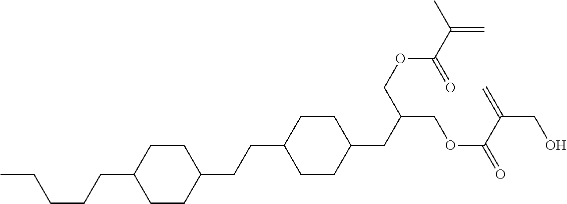 [SMILES: C=C(C)C(=O)OCC(COC(=O)C(=C)CO)CC1CCC(CCC2CCC(CCCCC)CC2)CC1] |
| 1ϵ-2-99 | 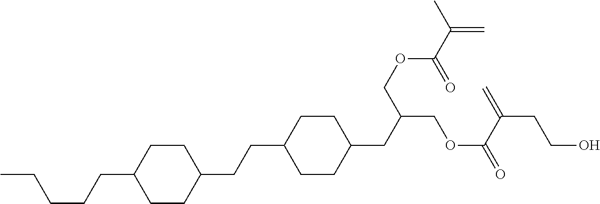 [SMILES: C=C(C)C(=O)OCC(COC(=O)C(=C)CCO)CC1CCC(CCC2CCC(CCCCC)CC2)CC1] |
| 1ϵ-2-100 | 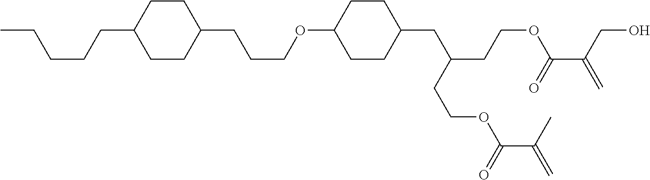 [SMILES: C=C(C)C(=O)OCCC(CCOC(=O)C(=C)CO)CC1CCC(OCCCC2CCC(CCCCC)CC2)CC1] |
| 1ϵ-2-101 | 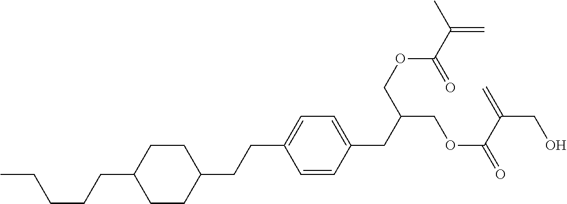 [SMILES: C=C(C)C(=O)OCC(COC(=O)C(=C)CO)Cc1ccc(CCC2CCC(CCCCC)CC2)cc1] |
| 1ϵ-2-102 | 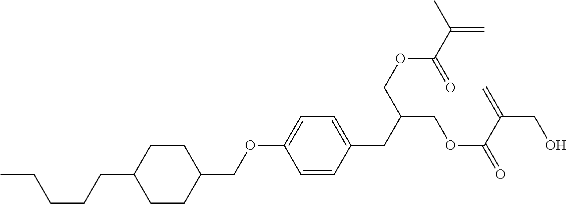 [SMILES: C=C(C)C(=O)OCC(COC(=O)C(=C)CO)Cc1ccc(OCC2CCC(CCCCC)CC2)cc1] |
| 1ϵ-2-103 | 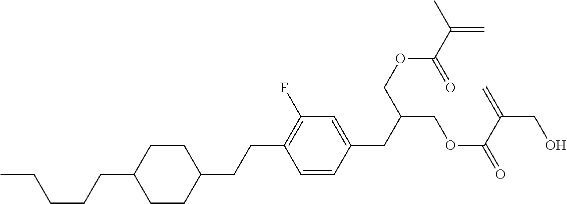 [SMILES: C=C(C)C(=O)OCC(COC(=O)C(=C)CO)Cc1ccc(CCC2CCC(CCCCC)CC2)c(F)c1] |
| 1ϵ-2-104 | 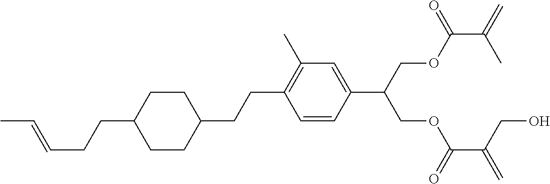 [SMILES: C=C(C)C(=O)OCC(COC(=O)C(=C)CO)c1ccc(CCC2CCC(CC/C=C/C)CC2)c(C)c1] |
| 1ϵ-2-105 | 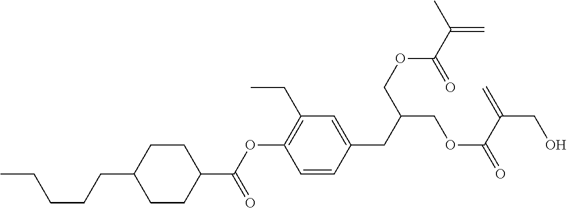 [SMILES: C=C(C)C(=O)OCC(COC(=O)C(=C)CO)Cc1ccc(OC(=O)C2CCC(CCCCC)CC2)c(CC)c1] |
| 1ϵ-2-106 | 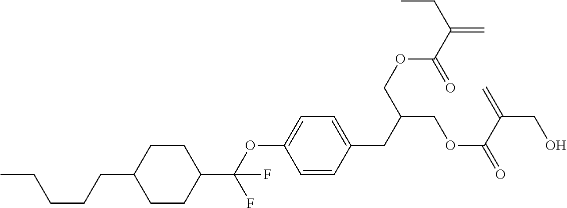 [SMILES: C=C(CC)C(=O)OCC(COC(=O)C(=C)CO)Cc1ccc(OC(F)(F)C2CCC(CCCCC)CC2)cc1] |
| 1ϵ-2-107 | 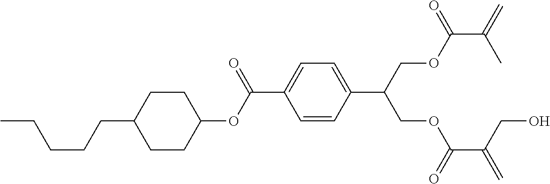 [SMILES: C=C(C)C(=O)OCC(COC(=O)C(=C)CO)c1ccc(C(=O)OC2CCC(CCCCC)CC2)cc1] |
| 1ϵ-2-108 | 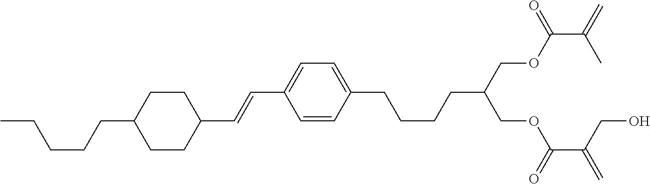 [SMILES: C=C(C)C(=O)OCC(CCCCc1ccc(/C=C/C2CCC(CCCCC)CC2)cc1)COC(=O)C(=C)CO] |
| 1ϵ-2-109 | 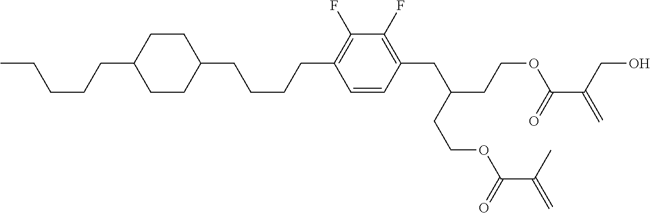 [SMILES: C=C(C)C(=O)OCCC(CCOC(=O)C(=C)CO)Cc1ccc(CCCCC2CCC(CCCCC)CC2)c(F)c1F] |
| 1ϵ-2-110 | 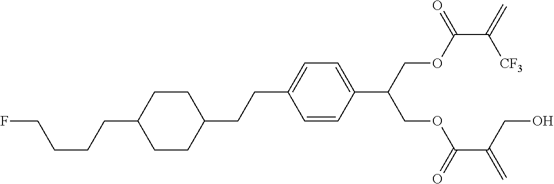 [SMILES: C=C(CO)C(=O)OCC(COC(=O)C(=C)C(F)(F)F)c1ccc(CCC2CCC(CCCCF)CC2)cc1] |
| 1ϵ-2-111 | 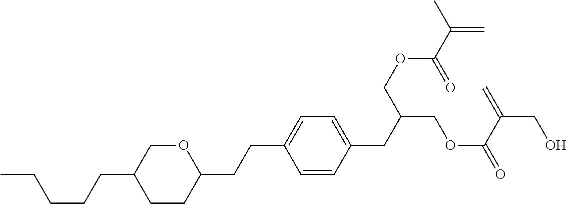 [SMILES: C=C(C)C(=O)OCC(COC(=O)C(=C)CO)Cc1ccc(CCC2CCC(CCCCC)CO2)cc1] |
| 1ϵ-2-112 | 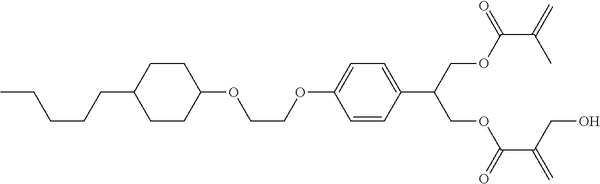 [SMILES: C=C(C)C(=O)OCC(COC(=O)C(=C)CO)c1ccc(OCCOC2CCC(CCCCC)CC2)cc1] |
| 1ϵ-2-113 | 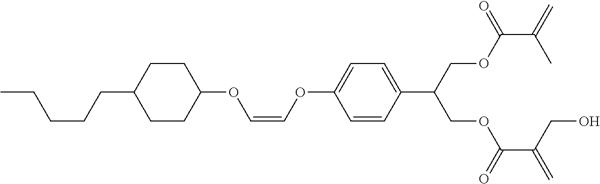 [SMILES: C=C(C)C(=O)OCC(COC(=O)C(=C)CO)c1ccc(O/C=C\OC2CCC(CCCCC)CC2)cc1] |
| 1ϵ-2-114 | 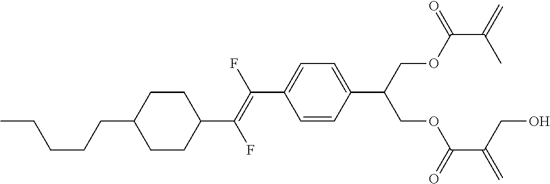 [SMILES: C=C(C)C(=O)OCC(COC(=O)C(=C)CO)c1ccc(/C(F)=C(\F)C2CCC(CCCCC)CC2)cc1] |
| 1ϵ-2-115 | 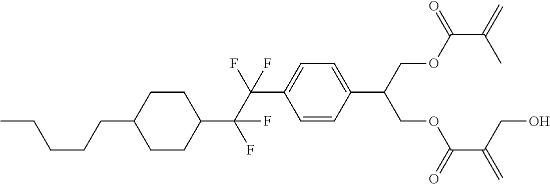 [SMILES: C=C(C)C(=O)OCC(COC(=O)C(=C)CO)c1ccc(C(F)(F)C(F)(F)C2CCC(CCCCC)CC2)cc1] |
| 1ϵ-2-116 | 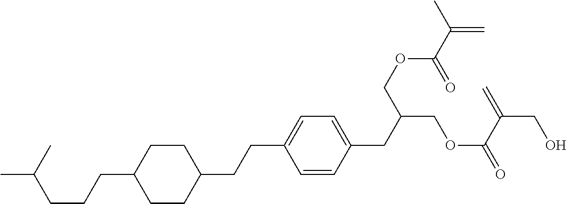 [SMILES: C=C(C)C(=O)OCC(COC(=O)C(=C)CO)Cc1ccc(CCC2CCC(CCCC(C)C)CC2)cc1] |
| 1ϵ-2-117 | 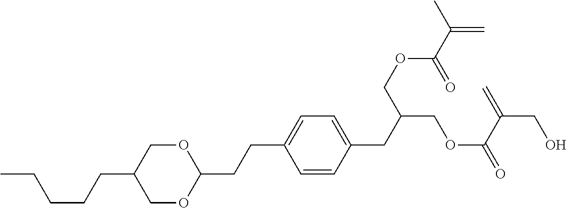 [SMILES: C=C(C)C(=O)OCC(COC(=O)C(=C)CO)Cc1ccc(CCC2OCC(CCCCC)CO2)cc1] |
| 1ϵ-2-118 | 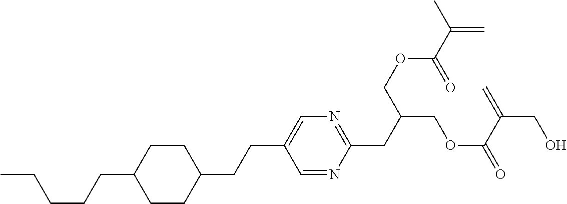 [SMILES: C=C(C)C(=O)OCC(COC(=O)C(=C)CO)Cc1ncc(CCC2CCC(CCCCC)CC2)cn1] |
| 1ϵ-2-119 | 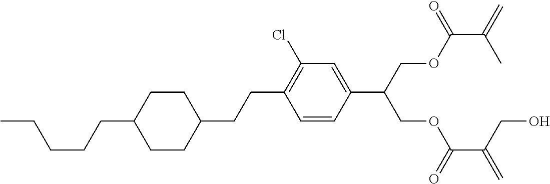 [SMILES: C=C(C)C(=O)OCC(COC(=O)C(=C)CO)c1ccc(CCC2CCC(CCCCC)CC2)c(Cl)c1] |
| 1ϵ-2-120 | 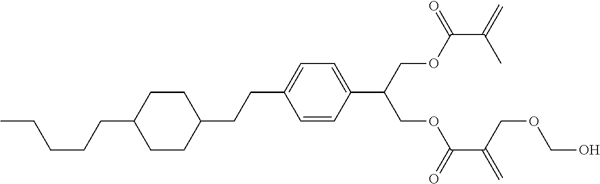 [SMILES: C=C(C)C(=O)OCC(COC(=O)C(=C)COCO)c1ccc(CCC2CCC(CCCCC)CC2)cc1] |
| 1ϵ-2-121 | 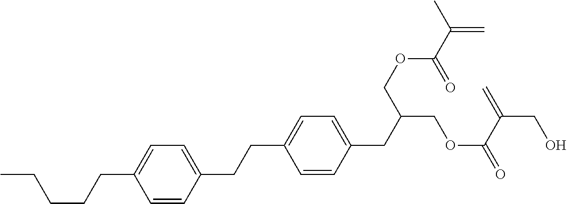 [SMILES: C=C(C)C(=O)OCC(COC(=O)C(=C)CO)Cc1ccc(CCc2ccc(CCCCC)cc2)cc1] |
| 1ϵ-2-122 | 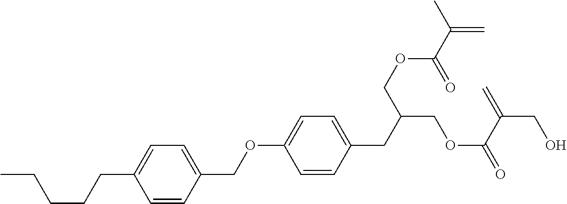 [SMILES: C=C(C)C(=O)OCC(COC(=O)C(=C)CO)Cc1ccc(OCc2ccc(CCCCC)cc2)cc1] |
| 1ϵ-2-123 | 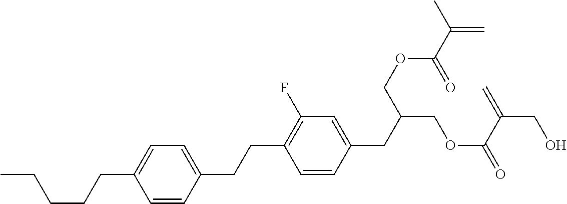 [SMILES: C=C(C)C(=O)OCC(COC(=O)C(=C)CO)Cc1ccc(CCc2ccc(CCCCC)cc2)c(F)c1] |
| 1ϵ-2-124 | 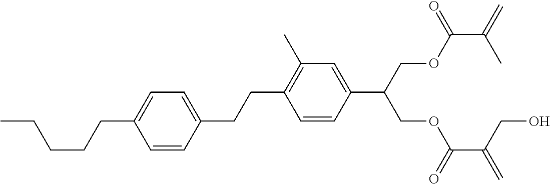 [SMILES: C=C(C)C(=O)OCC(COC(=O)C(=C)CO)c1ccc(CCc2ccc(CCCCC)cc2)c(C)c1] |
| 1ϵ-2-125 | 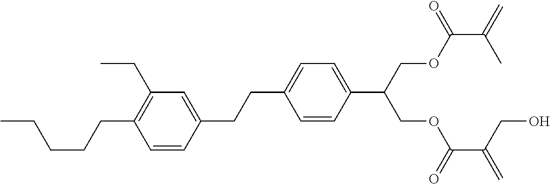 [SMILES: C=C(C)C(=O)OCC(COC(=O)C(=C)CO)c1ccc(CCc2ccc(CCCCC)c(CC)c2)cc1] |
| 1ϵ-2-126 | 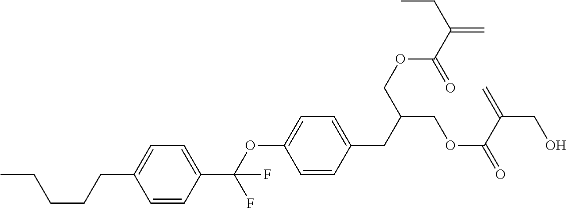 [SMILES: C=C(CC)C(=O)OCC(COC(=O)C(=C)CO)Cc1ccc(OC(F)(F)c2ccc(CCCCC)cc2)cc1] |
| 1ϵ-2-127 | 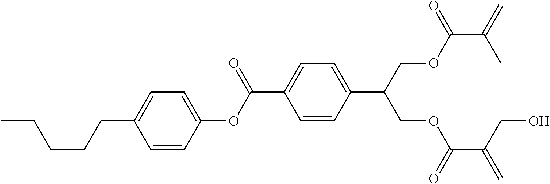 [SMILES: C=C(C)C(=O)OCC(COC(=O)C(=C)CO)c1ccc(C(=O)Oc2ccc(CCCCC)cc2)cc1] |
| 1ϵ-2-128 | 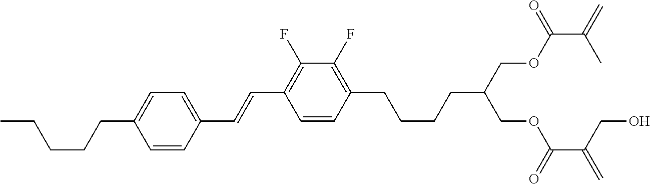 [SMILES: C=C(C)C(=O)OCC(CCCCc1ccc(/C=C/c2ccc(CCCCC)cc2)c(F)c1F)COC(=O)C(=C)CO] |
| 1ϵ-2-129 | 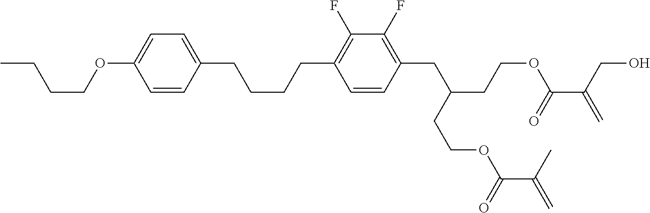 [SMILES: C=C(C)C(=O)OCCC(CCOC(=O)C(=C)CO)Cc1ccc(CCCCc2ccc(OCCCC)cc2)c(F)c1F] |
| 1ϵ-2-130 | 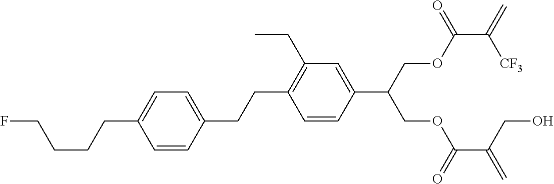 [SMILES: C=C(CO)C(=O)OCC(COC(=O)C(=C)C(F)(F)F)c1ccc(CCc2ccc(CCCCF)cc2)c(CC)c1] |
| 1ϵ-2-131 | 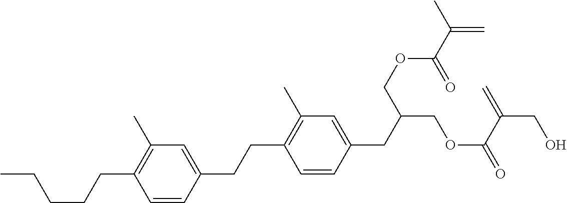 [SMILES: C=C(C)C(=O)OCC(COC(=O)C(=C)CO)Cc1ccc(CCc2ccc(CCCCC)c(C)c2)c(C)c1] |
| 1ϵ-2-132 | 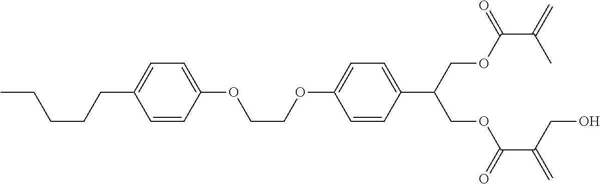 [SMILES: C=C(C)C(=O)OCC(COC(=O)C(=C)CO)c1ccc(OCCOc2ccc(CCCCC)cc2)cc1] |
| 1ϵ-2-133 | 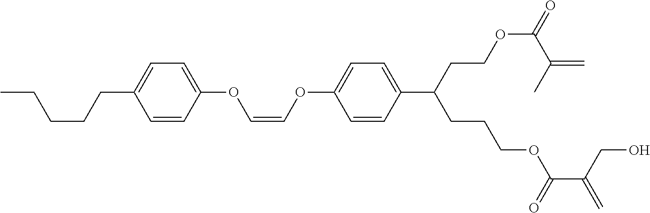 [SMILES: C=C(C)C(=O)OCCC(CCCOC(=O)C(=C)CO)c1ccc(O/C=C\Oc2ccc(CCCCC)cc2)cc1] |
| 1ϵ-2-134 | 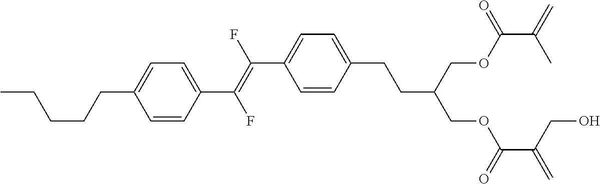 [SMILES: C=C(C)C(=O)OCC(CCc1ccc(/C(F)=C(\F)c2ccc(CCCCC)cc2)cc1)COC(=O)C(=C)CO] |
| 1ϵ-2-135 | 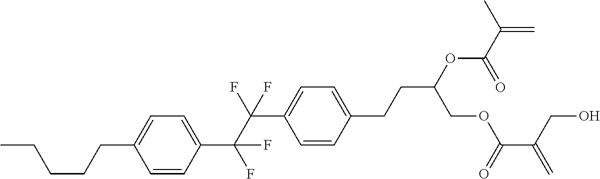 [SMILES: C=C(C)C(=O)OC(CCc1ccc(C(F)(F)C(F)(F)c2ccc(CCCCC)cc2)cc1)COC(=O)C(=C)CO] |
| 1ϵ-2-136 | 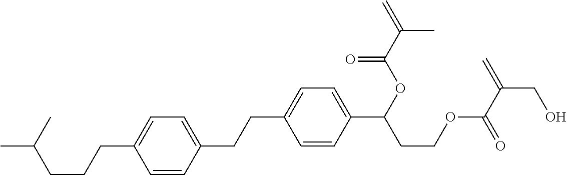 [SMILES: C=C(C)C(=O)OC(CCOC(=O)C(=C)CO)c1ccc(CCc2ccc(CCCC(C)C)cc2)cc1] |
| 1ϵ-2-137 | 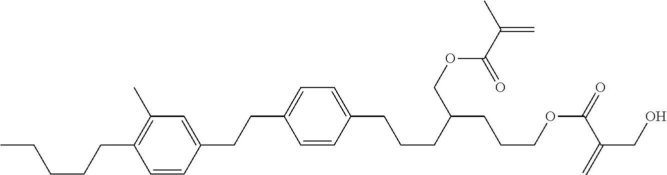 [SMILES: C=C(C)C(=O)OCC(CCCOC(=O)C(=C)CO)CCCc1ccc(CCc2ccc(CCCCC)c(C)c2)cc1] |
| 1ϵ-2-138 | 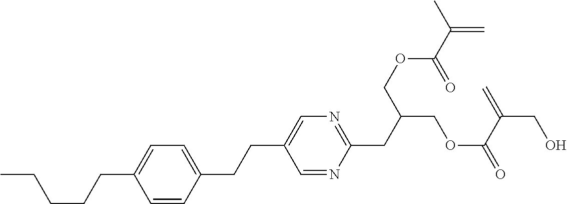 [SMILES: C=C(C)C(=O)OCC(COC(=O)C(=C)CO)Cc1ncc(CCc2ccc(CCCCC)cc2)cn1] |
| 1ϵ-2-139 | 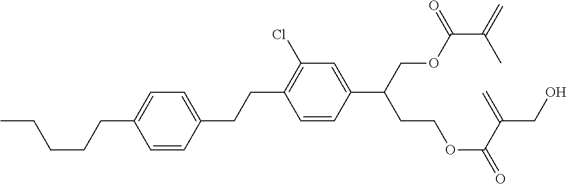 [SMILES: C=C(C)C(=O)OCC(CCOC(=O)C(=C)CO)c1ccc(CCc2ccc(CCCCC)cc2)c(Cl)c1] |
| 1ϵ-2-140 | 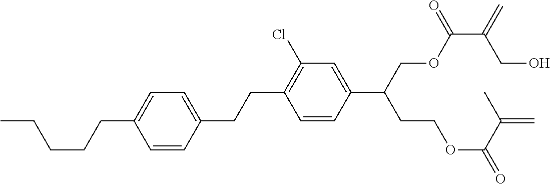 [SMILES: C=C(C)C(=O)OCCC(COC(=O)C(=C)CO)c1ccc(CCc2ccc(CCCCC)cc2)c(Cl)c1] |
| 1ϵ-2-141 | 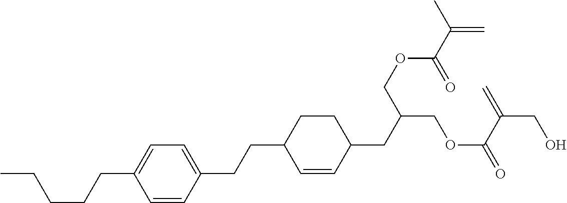 [SMILES: C=C(C)C(=O)OCC(COC(=O)C(=C)CO)CC1C=CC(CCc2ccc(CCCCC)cc2)CC1] |
| 1ϵ-2-142 | 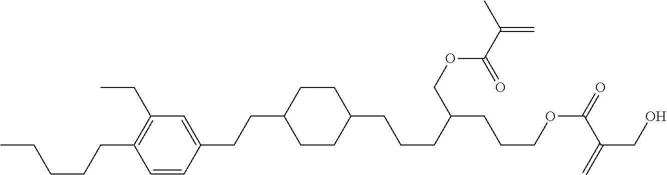 [SMILES: C=C(C)C(=O)OCC(CCCOC(=O)C(=C)CO)CCCC1CCC(CCc2ccc(CCCCC)c(CC)c2)CC1] |
| 1ϵ-2-143 | 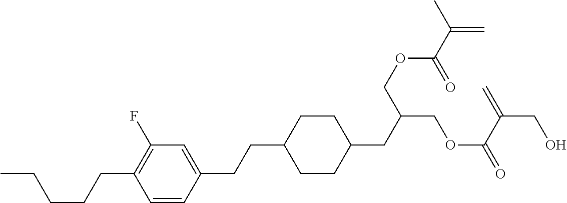 [SMILES: C=C(C)C(=O)OCC(COC(=O)C(=C)CO)CC1CCC(CCc2ccc(CCCCC)c(F)c2)CC1] |
| 1ϵ-2-144 | 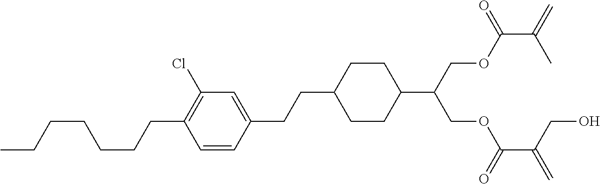 [SMILES: C=C(C)C(=O)OCC(COC(=O)C(=C)CO)C1CCC(CCc2ccc(CCCCCCC)c(Cl)c2)CC1] |
| 1ϵ-2-145 | 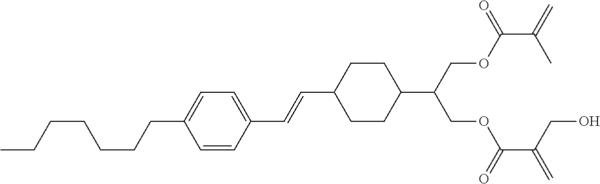 [SMILES: C=C(C)C(=O)OCC(COC(=O)C(=C)CO)C1CCC(/C=C/c2ccc(CCCCCCC)cc2)CC1] |
| 1ϵ-2-146 | 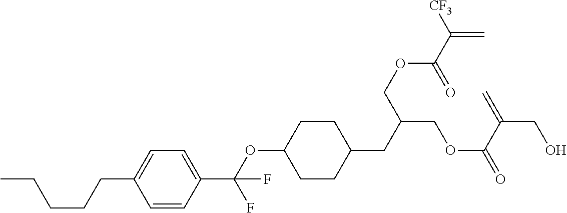 [SMILES: C=C(CO)C(=O)OCC(COC(=O)C(=C)C(F)(F)F)CC1CCC(OC(F)(F)c2ccc(CCCCC)cc2)CC1] |
| 1ϵ-2-147 | 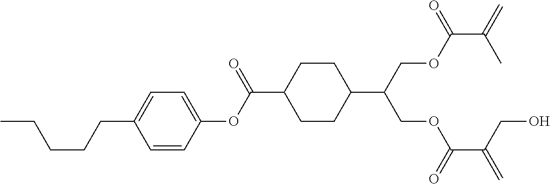 [SMILES: C=C(C)C(=O)OCC(COC(=O)C(=C)CO)C1CCC(C(=O)Oc2ccc(CCCCC)cc2)CC1] |
| 1ϵ-2-148 | 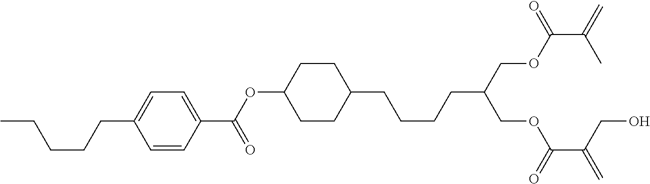 [SMILES: C=C(C)C(=O)OCC(CCCCC1CCC(OC(=O)c2ccc(CCCCC)cc2)CC1)COC(=O)C(=C)CO] |
| 1ϵ-2-149 | 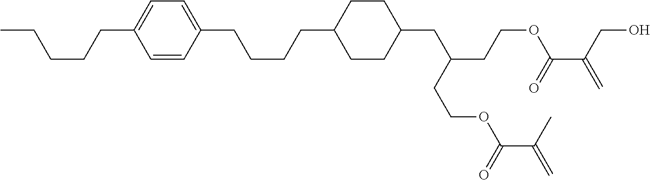 [SMILES: C=C(C)C(=O)OCCC(CCOC(=O)C(=C)CO)CC1CCC(CCCCc2ccc(CCCCC)cc2)CC1] |
| 1ϵ-2-150 | 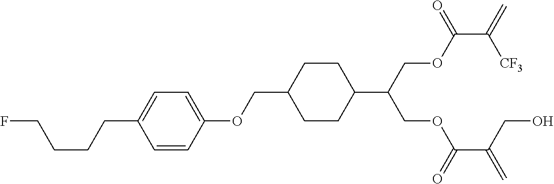 [SMILES: C=C(CO)C(=O)OCC(COC(=O)C(=C)C(F)(F)F)C1CCC(COc2ccc(CCCCF)cc2)CC1] |
| 1ϵ-2-151 | 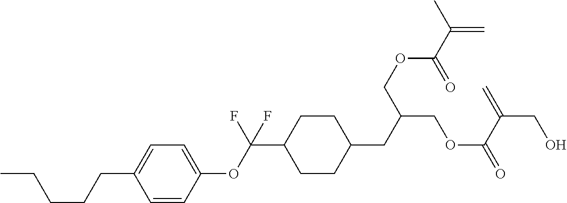 [SMILES: C=C(C)C(=O)OCC(COC(=O)C(=C)CO)CC1CCC(C(F)(F)Oc2ccc(CCCCC)cc2)CC1] |
| 1ϵ-2-152 | 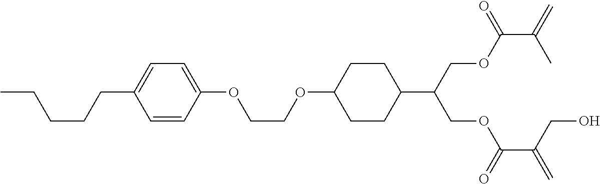 [SMILES: C=C(C)C(=O)OCC(COC(=O)C(=C)CO)C1CCC(OCCOc2ccc(CCCCC)cc2)CC1] |
| 1ϵ-2-153 | 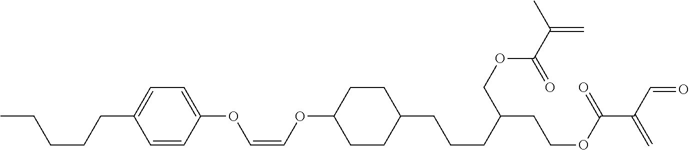 [SMILES: C=C(C)C(=O)OCC(CCCC1CCC(O/C=C\Oc2ccc(CCCCC)cc2)CC1)CCOC(=O)C(=C)C=O] |
| 1ϵ-2-154 | 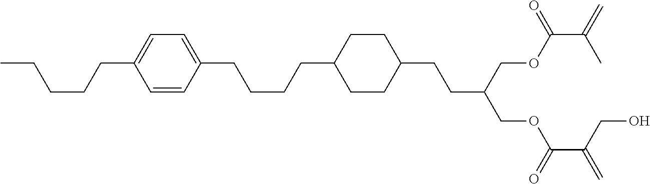 [SMILES: C=C(C)C(=O)OCC(CCC1CCC(CCCCc2ccc(CCCCC)cc2)CC1)COC(=O)C(=C)CO] |
| 1ϵ-2-155 | 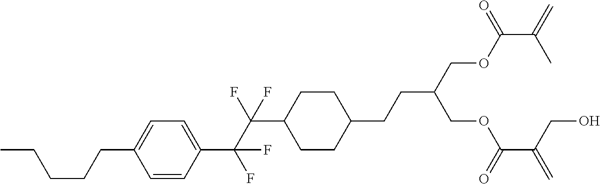 [SMILES: C=C(C)C(=O)OCC(CCC1CCC(C(F)(F)C(F)(F)c2ccc(CCCCC)cc2)CC1)COC(=O)C(=C)CO] |
| 1ϵ-2-156 | 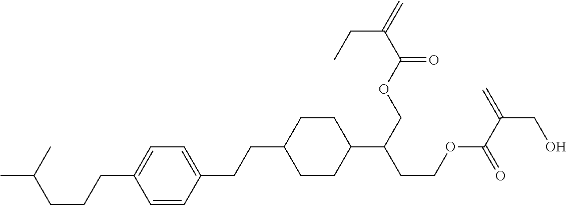 [SMILES: C=C(CC)C(=O)OCC(CCOC(=O)C(=C)CO)C1CCC(CCc2ccc(CCCC(C)C)cc2)CC1] |
| 1ϵ-2-157 | 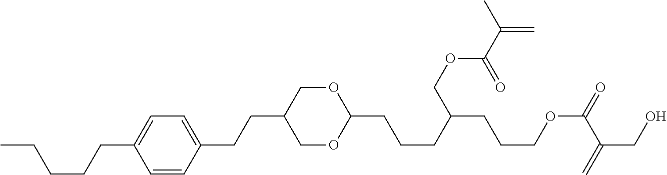 [SMILES: C=C(C)C(=O)OCC(CCCOC(=O)C(=C)CO)CCCC1OCC(CCc2ccc(CCCCC)cc2)CO1] |
| 1ϵ-2-158 | 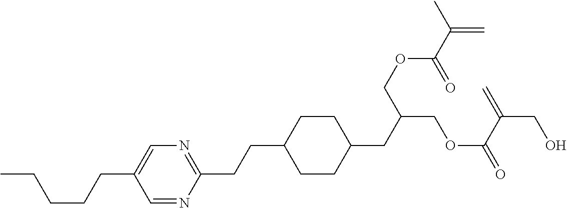 [SMILES: C=C(C)C(=O)OCC(COC(=O)C(=C)CO)CC1CCC(CCc2ncc(CCCCC)cn2)CC1] |
| 1ϵ-2-159 | 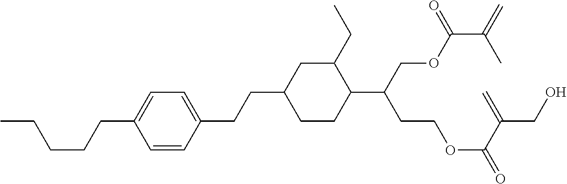 [SMILES: C=C(C)C(=O)OCC(CCOC(=O)C(=C)CO)C1CCC(CCc2ccc(CCCCC)cc2)CC1CC] |
| 1ϵ-2-160 | 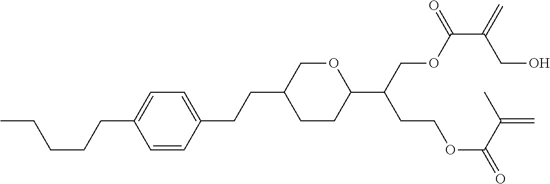 [SMILES: C=C(C)C(=O)OCCC(COC(=O)C(=C)CO)C1CCC(CCc2ccc(CCCCC)cc2)CO1] |
| 1ϵ-2-161 | 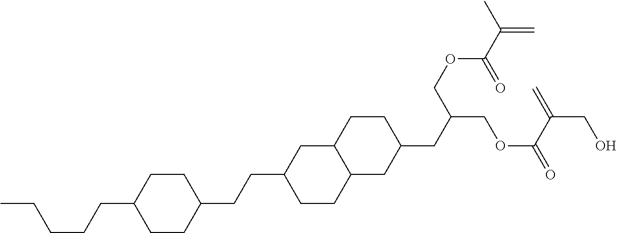 [SMILES: C=C(C)C(=O)OCC(COC(=O)C(=C)CO)CC1CCC2CC(CCC3CCC(CCCCC)CC3)CCC2C1] |
| 1ϵ-2-162 | 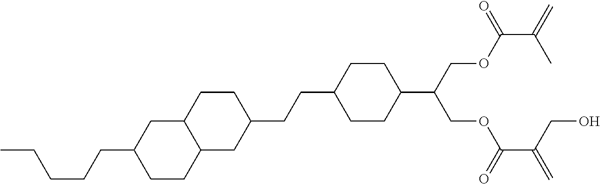 [SMILES: C=C(C)C(=O)OCC(COC(=O)C(=C)CO)C1CCC(CCC2CCC3CC(CCCCC)CCC3C2)CC1] |
| 1ϵ-2-163 | 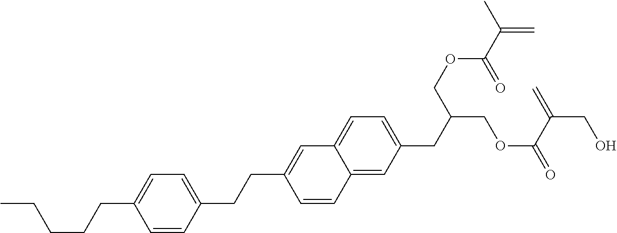 [SMILES: C=C(C)C(=O)OCC(COC(=O)C(=C)CO)Cc1ccc2cc(CCc3ccc(CCCCC)cc3)ccc2c1] |
| 1ϵ-2-164 | 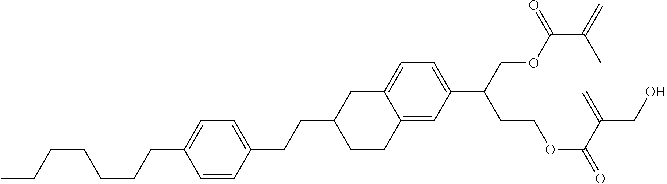 [SMILES: C=C(C)C(=O)OCC(CCOC(=O)C(=C)CO)c1ccc2c(c1)CCC(CCc1ccc(CCCCCCC)cc1)C2] |
| 1ϵ-2-165 | 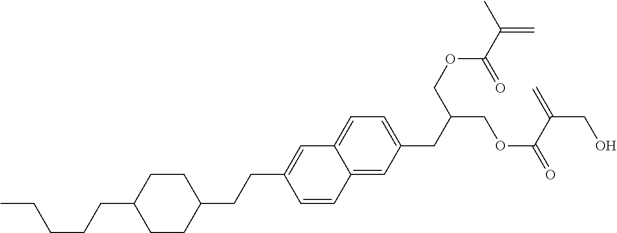 [SMILES: C=C(C)C(=O)OCC(COC(=O)C(=C)CO)Cc1ccc2cc(CCC3CCC(CCCCC)CC3)ccc2c1] |
| 1ϵ-2-166 | 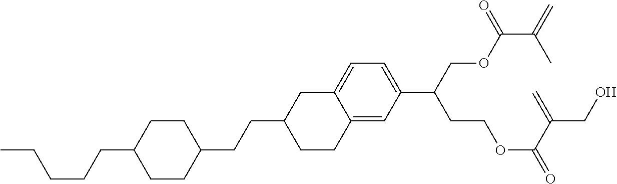 [SMILES: C=C(C)C(=O)OCC(CCOC(=O)C(=C)CO)c1ccc2c(c1)CCC(CCC1CCC(CCCCC)CC1)C2] |
| 1ϵ-2-167 | 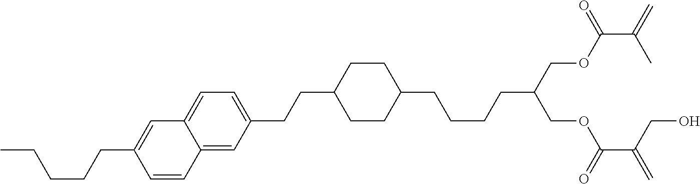 [SMILES: C=C(C)C(=O)OCC(CCCCC1CCC(CCc2ccc3cc(CCCCC)ccc3c2)CC1)COC(=O)C(=C)CO] |
| 1ϵ-2-168 | 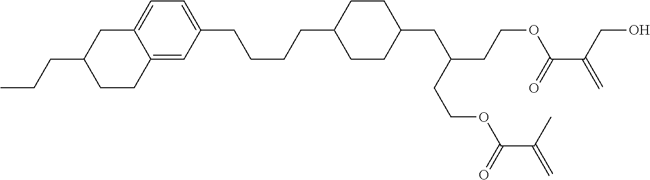 [SMILES: C=C(C)C(=O)OCCC(CCOC(=O)C(=C)CO)CC1CCC(CCCCc2ccc3c(c2)CCC(CCC)C3)CC1] |
| 1ϵ-2-169 | 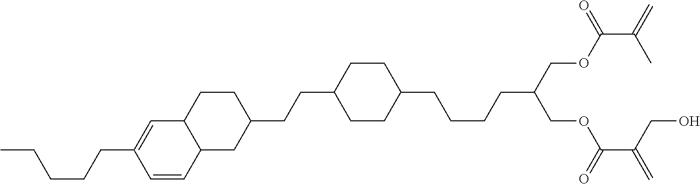 [SMILES: C=C(C)C(=O)OCC(CCCCC1CCC(CCC2CCC3C=C(CCCCC)C=CC3C2)CC1)COC(=O)C(=C)CO] |
| 1ϵ-2-170 | 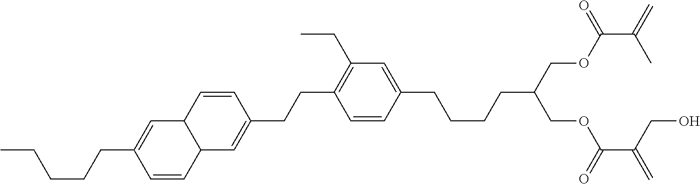 [SMILES: C=C(C)C(=O)OCC(CCCCc1ccc(CCC2=CC3C=CC(CCCCC)=CC3C=C2)c(CC)c1)COC(=O)C(=C)CO] |
| 1ϵ-2-171 | 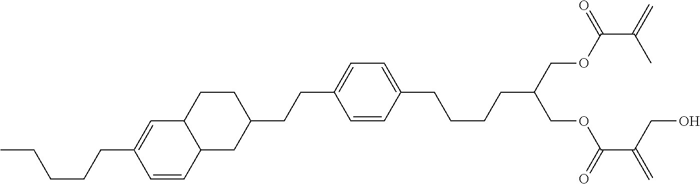 [SMILES: C=C(C)C(=O)OCC(CCCCc1ccc(CCC2CCC3C=C(CCCCC)C=CC3C2)cc1)COC(=O)C(=C)CO] |
| 1ϵ-2-172 | 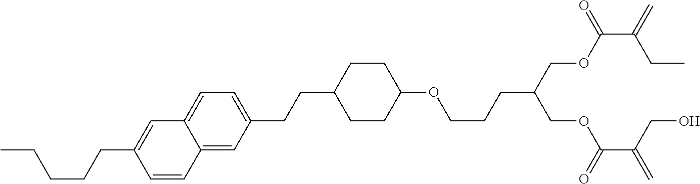 [SMILES: C=C(CC)C(=O)OCC(CCCOC1CCC(CCc2ccc3cc(CCCCC)ccc3c2)CC1)COC(=O)C(=C)CO] |
| 1ϵ-2-173 | 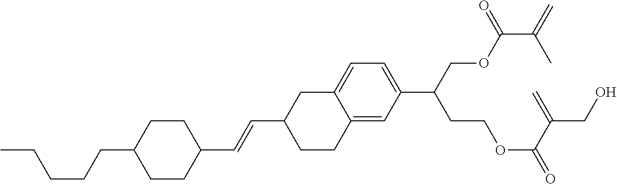 [SMILES: C=C(C)C(=O)OCC(CCOC(=O)C(=C)CO)c1ccc2c(c1)CCC(/C=C/C1CCC(CCCCC)CC1)C2] |
| 1ϵ-2-174 | 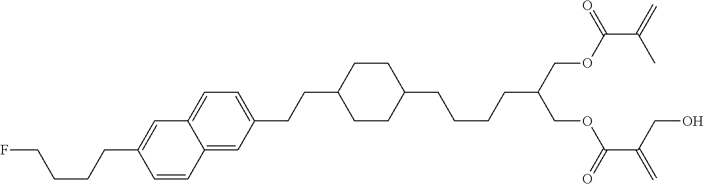 [SMILES: C=C(C)C(=O)OCC(CCCCC1CCC(CCc2ccc3cc(CCCCF)ccc3c2)CC1)COC(=O)C(=C)CO] |
| 1ϵ-2-175 | 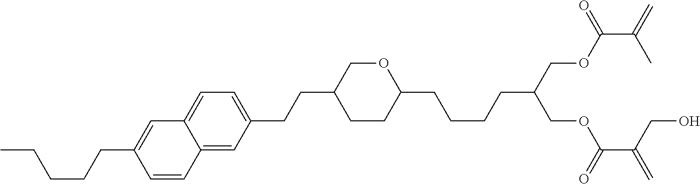 [SMILES: C=C(C)C(=O)OCC(CCCCC1CCC(CCc2ccc3cc(CCCCC)ccc3c2)CO1)COC(=O)C(=C)CO] |
| 1ϵ-2-176 | 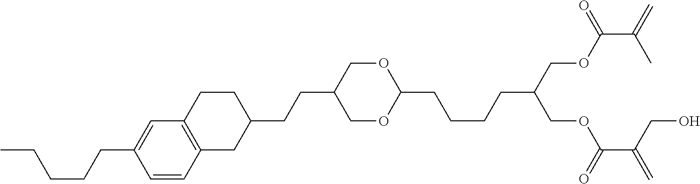 [SMILES: C=C(C)C(=O)OCC(CCCCC1OCC(CCC2CCc3cc(CCCCC)ccc3C2)CO1)COC(=O)C(=C)CO] |
| 1ϵ-2-177 | 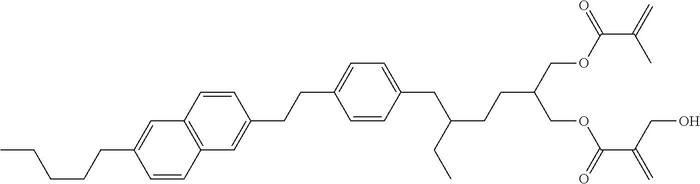 [SMILES: C=C(C)C(=O)OCC(CCC(CC)Cc1ccc(CCc2ccc3cc(CCCCC)ccc3c2)cc1)COC(=O)C(=C)CO] |
| 1ϵ-2-178 | 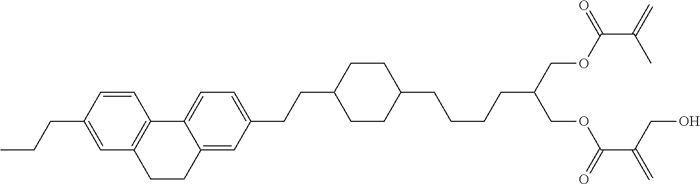 [SMILES: C=C(C)C(=O)OCC(CCCCC1CCC(CCc2ccc3c(c2)CCc2cc(CCC)ccc2-3)CC1)COC(=O)C(=C)CO] |
| 1ϵ-2-179 | 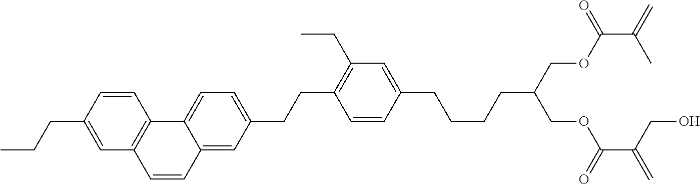 [SMILES: C=C(C)C(=O)OCC(CCCCc1ccc(CCc2ccc3c(ccc4cc(CCC)ccc43)c2)c(CC)c1)COC(=O)C(=C)CO] |
| 1ϵ-2-180 | 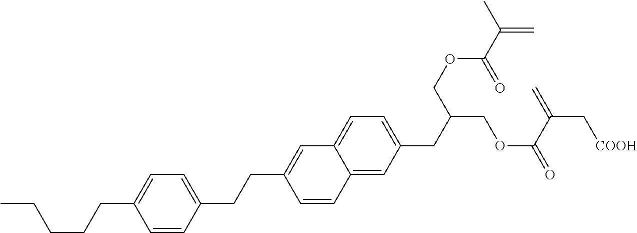 [SMILES: C=C(C)C(=O)OCC(COC(=O)C(=C)CC(=O)O)Cc1ccc2cc(CCc3ccc(CCCCC)cc3)ccc2c1] |
| 1ϵ-3-1 | 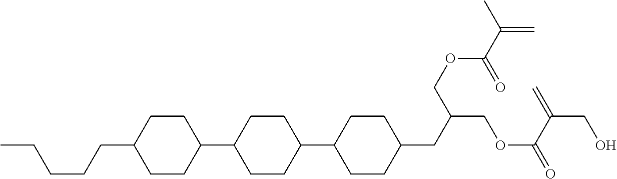 [SMILES: C=C(C)C(=O)OCC(COC(=O)C(=C)CO)CC1CCC(C2CCC(C3CCC(CCCCC)CC3)CC2)CC1] |
| 1ϵ-3-2 | 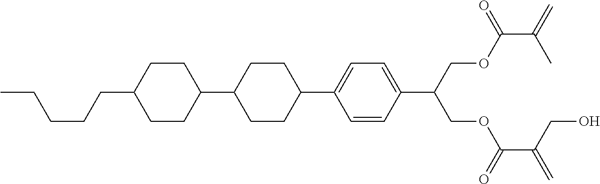 [SMILES: C=C(C)C(=O)OCC(COC(=O)C(=C)CO)c1ccc(C2CCC(C3CCC(CCCCC)CC3)CC2)cc1] |
| 1ϵ-3-3 | 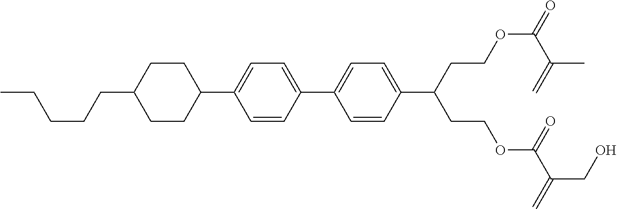 [SMILES: C=C(C)C(=O)OCCC(CCOC(=O)C(=C)CO)c1ccc(-c2ccc(C3CCC(CCCCC)CC3)cc2)cc1] |
| 1ϵ-3-4 | 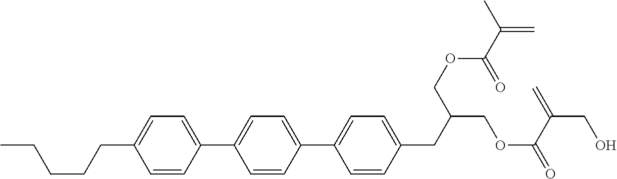 [SMILES: C=C(C)C(=O)OCC(COC(=O)C(=C)CO)Cc1ccc(-c2ccc(-c3ccc(CCCCC)cc3)cc2)cc1] |
| 1ϵ-3-5 | 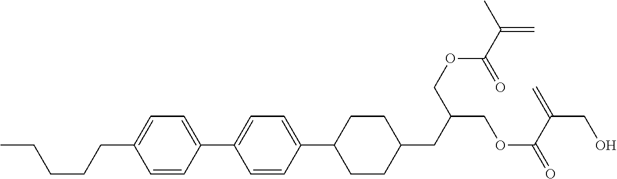 [SMILES: C=C(C)C(=O)OCC(COC(=O)C(=C)CO)CC1CCC(c2ccc(-c3ccc(CCCCC)cc3)cc2)CC1] |
| 1ϵ-3-6 | 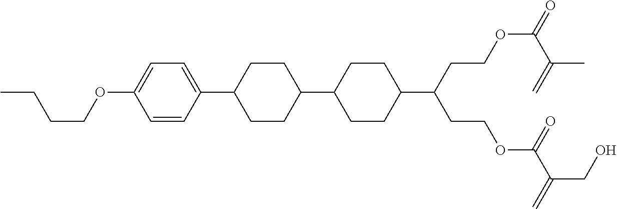 [SMILES: C=C(C)C(=O)OCCC(CCOC(=O)C(=C)CO)C1CCC(C2CCC(c3ccc(OCCCC)cc3)CC2)CC1] |
| 1ϵ-3-7 | 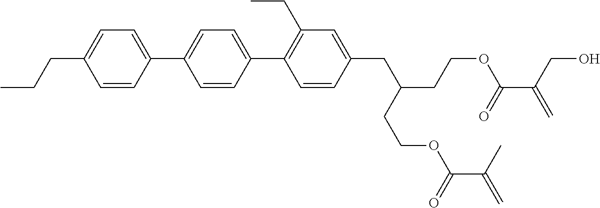 [SMILES: C=C(C)C(=O)OCCC(CCOC(=O)C(=C)CO)Cc1ccc(-c2ccc(-c3ccc(CCC)cc3)cc2)c(CC)c1] |
| 1ϵ-3-8 | 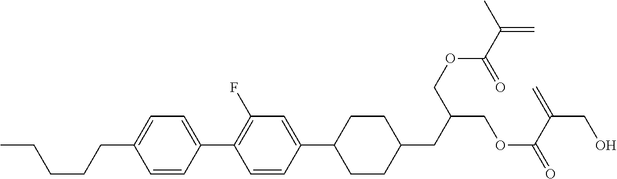 [SMILES: C=C(C)C(=O)OCC(COC(=O)C(=C)CO)CC1CCC(c2ccc(-c3ccc(CCCCC)cc3)c(F)c2)CC1] |
| 1ϵ-3-9 | 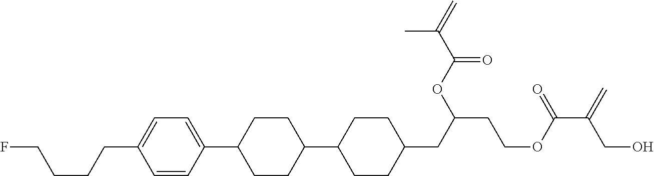 [SMILES: C=C(C)C(=O)OC(CCOC(=O)C(=C)CO)CC1CCC(C2CCC(c3ccc(CCCCF)cc3)CC2)CC1] |
| 1ϵ-3-10 | 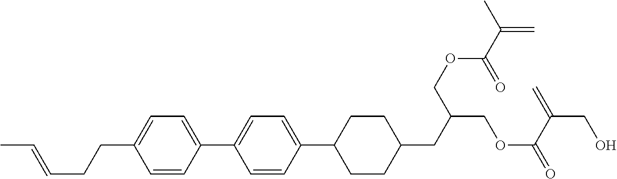 [SMILES: C=C(C)C(=O)OCC(COC(=O)C(=C)CO)CC1CCC(c2ccc(-c3ccc(CC/C=C/C)cc3)cc2)CC1] |
| 1ϵ-3-11 | 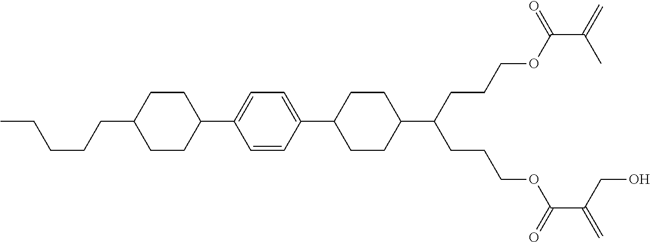 [SMILES: C=C(C)C(=O)OCCCC(CCCOC(=O)C(=C)CO)C1CCC(c2ccc(C3CCC(CCCCC)CC3)cc2)CC1] |
| 1ϵ-3-12 | 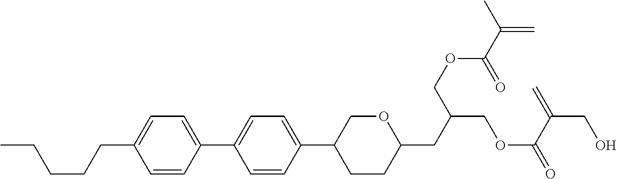 [SMILES: C=C(C)C(=O)OCC(COC(=O)C(=C)CO)CC1CCC(c2ccc(-c3ccc(CCCCC)cc3)cc2)CO1] |
| 1ϵ-3-13 | 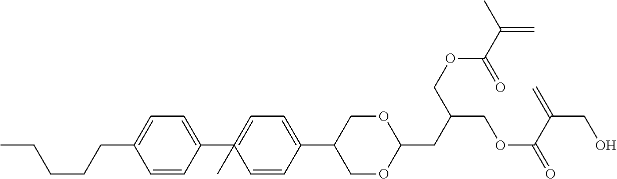 |
| 1ϵ-3-14 | 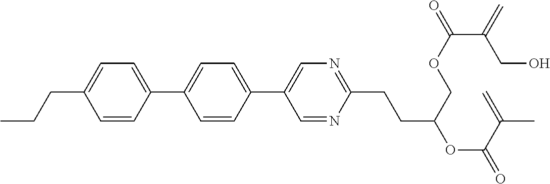 [SMILES: C=C(C)C(=O)OC(CCc1ncc(-c2ccc(-c3ccc(CCC)cc3)cc2)cn1)COC(=O)C(=C)CO] |
| 1ϵ-3-15 | 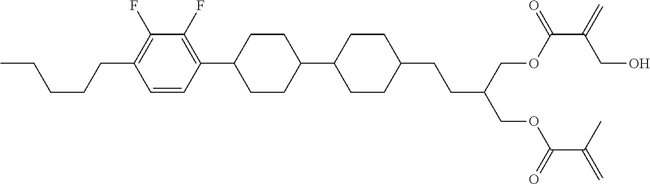 [SMILES: C=C(C)C(=O)OCC(CCC1CCC(C2CCC(c3ccc(CCCCC)c(F)c3F)CC2)CC1)COC(=O)C(=C)CO] |
| 1ϵ-3-16 | 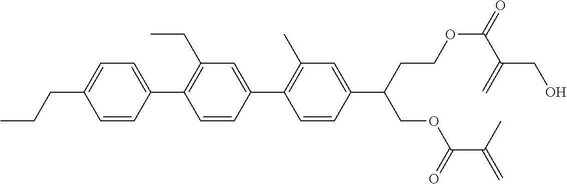 [SMILES: C=C(C)C(=O)OCC(CCOC(=O)C(=C)CO)c1ccc(-c2ccc(-c3ccc(CCC)cc3)c(CC)c2)c(C)c1] |
| 1ϵ-3-17 | 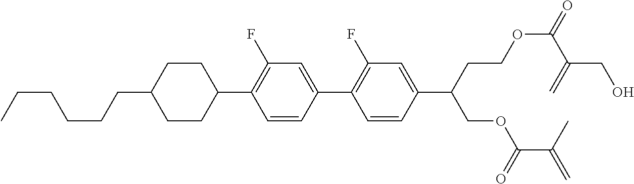 [SMILES: C=C(C)C(=O)OCC(CCOC(=O)C(=C)CO)c1ccc(-c2ccc(C3CCC(CCCCCC)CC3)c(F)c2)c(F)c1] |
| 1ϵ-3-18 | 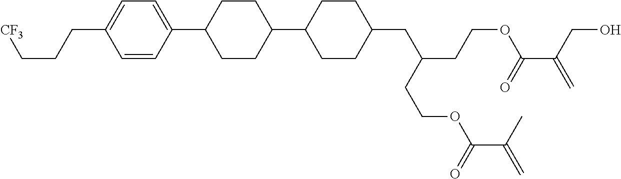 [SMILES: C=C(C)C(=O)OCCC(CCOC(=O)C(=C)CO)CC1CCC(C2CCC(c3ccc(CCCC(F)(F)F)cc3)CC2)CC1] |
| 1ϵ-3-19 | 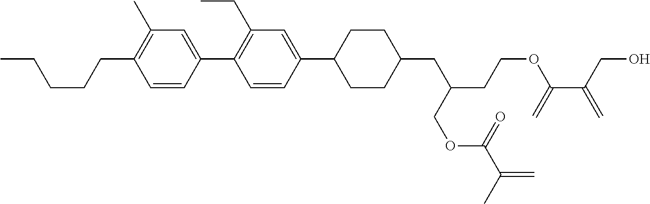 [SMILES: C=C(C)C(=O)OCC(CCOC(=C)C(=C)CO)CC1CCC(c2ccc(-c3ccc(CCCCC)c(C)c3)c(CC)c2)CC1] |
| 1ϵ-3-20 | 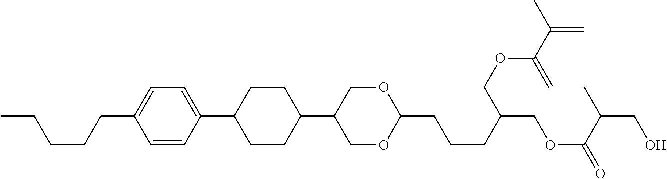 [SMILES: C=C(C)C(=C)OCC(CCCC1OCC(C2CCC(c3ccc(CCCCC)cc3)CC2)CO1)COC(=O)C(C)CO] |
| 1ϵ-3-21 | 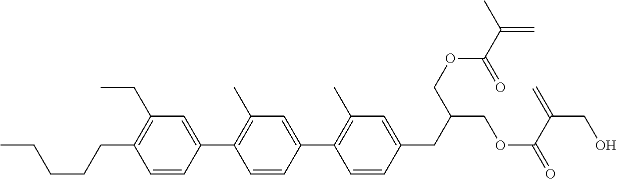 [SMILES: C=C(C)C(=O)OCC(COC(=O)C(=C)CO)Cc1ccc(-c2ccc(-c3ccc(CCCCC)c(CC)c3)c(C)c2)c(C)c1] |
| 1ϵ-3-22 | 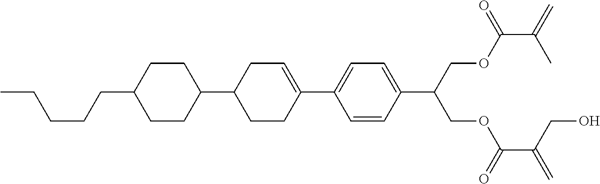 [SMILES: C=C(C)C(=O)OCC(COC(=O)C(=C)CO)c1ccc(C2=CCC(C3CCC(CCCCC)CC3)CC2)cc1] |
| 1ϵ-3-23 | 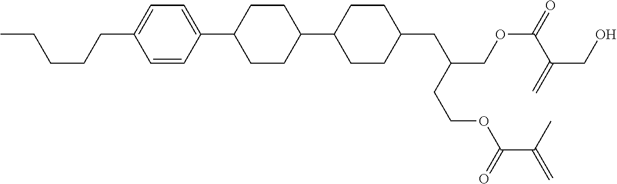 [SMILES: C=C(C)C(=O)OCCC(COC(=O)C(=C)CO)CC1CCC(C2CCC(c3ccc(CCCCC)cc3)CC2)CC1] |
| 1ϵ-3-24 | 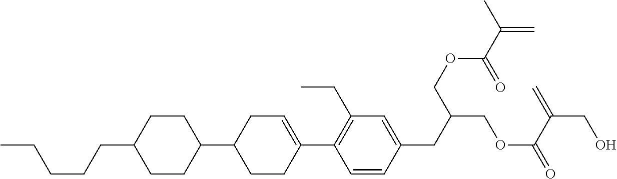 [SMILES: C=C(C)C(=O)OCC(COC(=O)C(=C)CO)Cc1ccc(C2=CCC(C3CCC(CCCCC)CC3)CC2)c(CC)c1] |
| 1ϵ-3-25 | 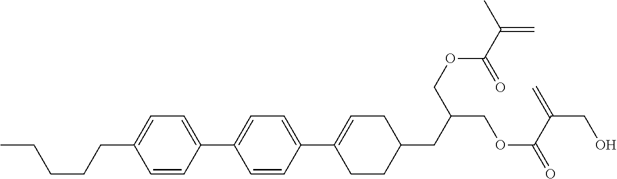 [SMILES: C=C(C)C(=O)OCC(COC(=O)C(=C)CO)CC1CC=C(c2ccc(-c3ccc(CCCCC)cc3)cc2)CC1] |
| 1ϵ-3-26 | 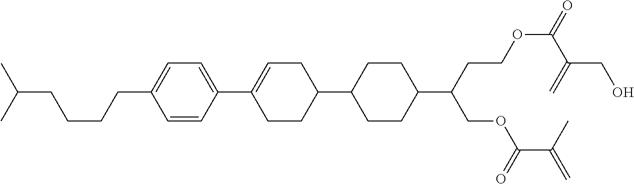 [SMILES: C=C(C)C(=O)OCC(CCOC(=O)C(=C)CO)C1CCC(C2CC=C(c3ccc(CCCCC(C)C)cc3)CC2)CC1] |
| 1ϵ-3-27 | 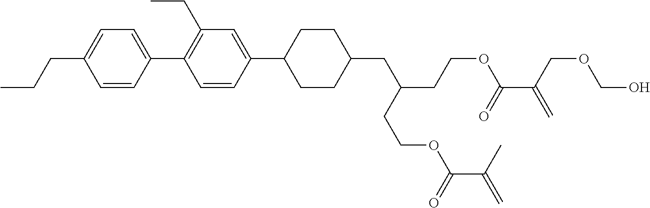 [SMILES: C=C(C)C(=O)OCCC(CCOC(=O)C(=C)COCO)CC1CCC(c2ccc(-c3ccc(CCC)cc3)c(CC)c2)CC1] |
| 1ϵ-3-28 | 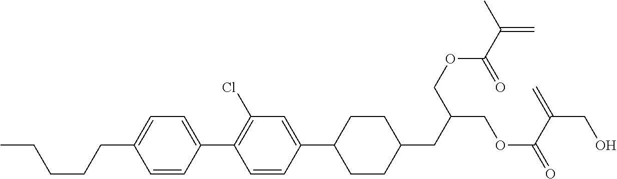 [SMILES: C=C(C)C(=O)OCC(COC(=O)C(=C)CO)CC1CCC(c2ccc(-c3ccc(CCCCC)cc3)c(Cl)c2)CC1] |
| 1ϵ-3-29 | 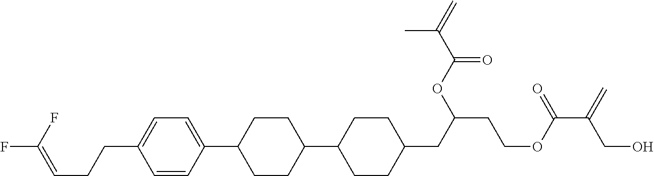 [SMILES: C=C(C)C(=O)OC(CCOC(=O)C(=C)CO)CC1CCC(C2CCC(c3ccc(CCC=C(F)F)cc3)CC2)CC1] |
| 1ϵ-3-30 | 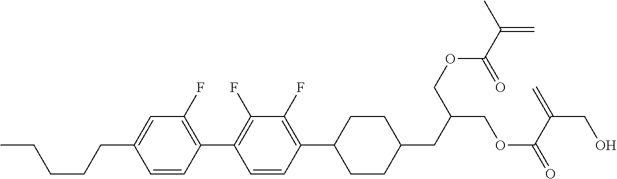 [SMILES: C=C(C)C(=O)OCC(COC(=O)C(=C)CO)CC1CCC(c2ccc(-c3ccc(CCCCC)cc3F)c(F)c2F)CC1] |
| 1ϵ-3-31 | 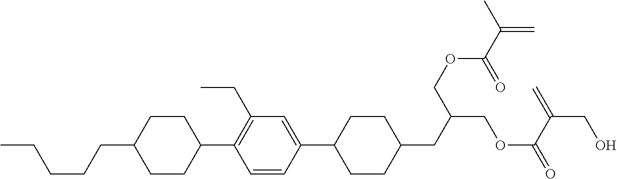 [SMILES: C=C(C)C(=O)OCC(COC(=O)C(=C)CO)CC1CCC(c2ccc(C3CCC(CCCCC)CC3)c(CC)c2)CC1] |
| 1ϵ-3-32 | 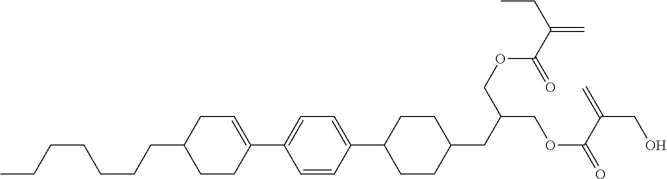 [SMILES: C=C(CC)C(=O)OCC(COC(=O)C(=C)CO)CC1CCC(c2ccc(C3=CCC(CCCCCCC)CC3)cc2)CC1] |
| 1ϵ-3-33 | 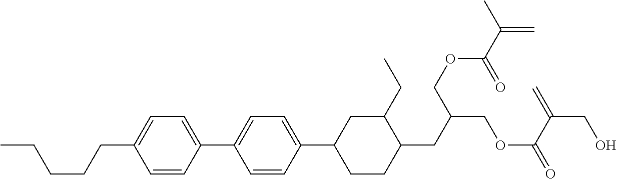 [SMILES: C=C(C)C(=O)OCC(COC(=O)C(=C)CO)CC1CCC(c2ccc(-c3ccc(CCCCC)cc3)cc2)CC1CC] |
| 1ϵ-3-34 | 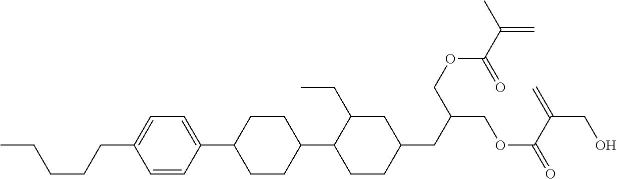 [SMILES: C=C(C)C(=O)OCC(COC(=O)C(=C)CO)CC1CCC(C2CCC(c3ccc(CCCCC)cc3)CC2)C(CC)C1] |
| 1ϵ-3-35 | 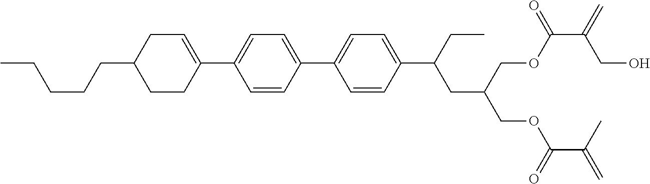 [SMILES: C=C(C)C(=O)OCC(COC(=O)C(=C)CO)CC(CC)c1ccc(-c2ccc(C3=CCC(CCCCC)CC3)cc2)cc1] |
| 1ϵ-3-36 | 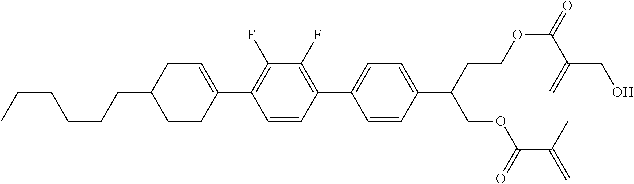 [SMILES: C=C(C)C(=O)OCC(CCOC(=O)C(=C)CO)c1ccc(-c2ccc(C3=CCC(CCCCCC)CC3)c(F)c2F)cc1] |
| 1ϵ-3-37 | 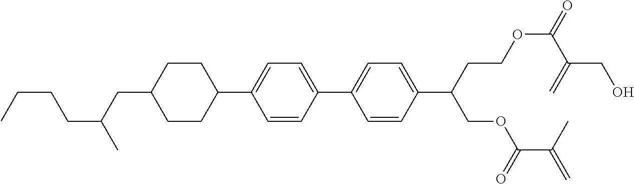 [SMILES: C=C(C)C(=O)OCC(CCOC(=O)C(=C)CO)c1ccc(-c2ccc(C3CCC(CC(C)CCCC)CC3)cc2)cc1] |
| 1ϵ-3-38 | 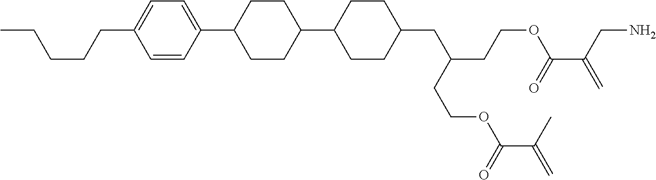 [SMILES: C=C(C)C(=O)OCCC(CCOC(=O)C(=C)CN)CC1CCC(C2CCC(c3ccc(CCCCC)cc3)CC2)CC1] |
| 1ϵ-3-39 | 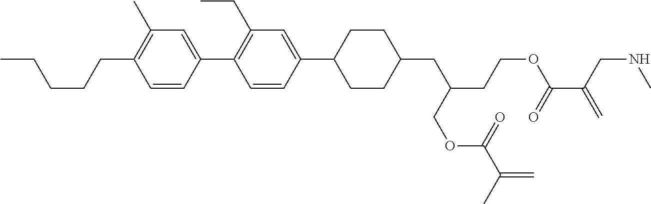 [SMILES: C=C(C)C(=O)OCC(CCOC(=O)C(=C)CNC)CC1CCC(c2ccc(-c3ccc(CCCCC)c(C)c3)c(CC)c2)CC1] |
| 1ϵ-3-40 | 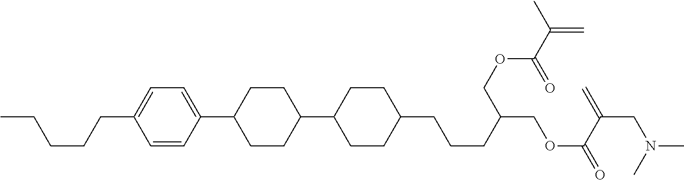 [SMILES: C=C(C)C(=O)OCC(CCCC1CCC(C2CCC(c3ccc(CCCCC)cc3)CC2)CC1)COC(=O)C(=C)CN(C)C] |
| 1ϵ-3-41 | 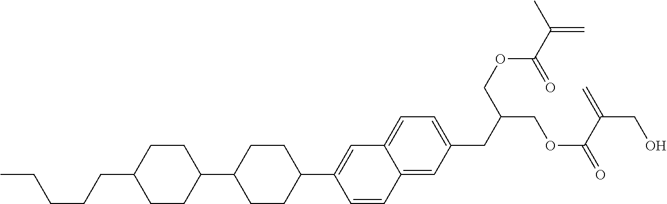 [SMILES: C=C(C)C(=O)OCC(COC(=O)C(=C)CO)Cc1ccc2cc(C3CCC(C4CCC(CCCCC)CC4)CC3)ccc2c1] |
| 1ϵ-3-42 | 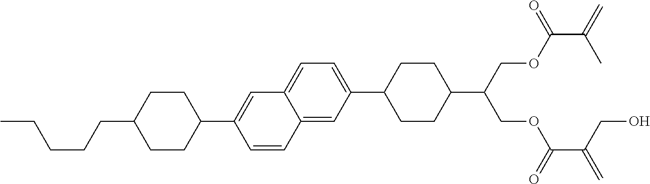 [SMILES: C=C(C)C(=O)OCC(COC(=O)C(=C)CO)C1CCC(c2ccc3cc(C4CCC(CCCCC)CC4)ccc3c2)CC1] |
| 1ϵ-3-43 | 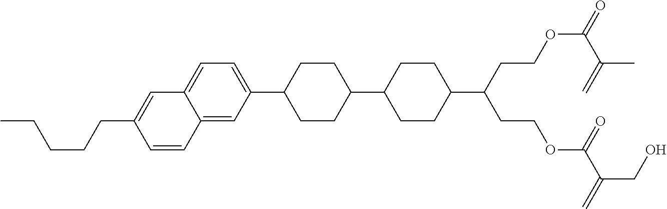 [SMILES: C=C(C)C(=O)OCCC(CCOC(=O)C(=C)CO)C1CCC(C2CCC(c3ccc4cc(CCCCC)ccc4c3)CC2)CC1] |
| 1ϵ-3-44 | 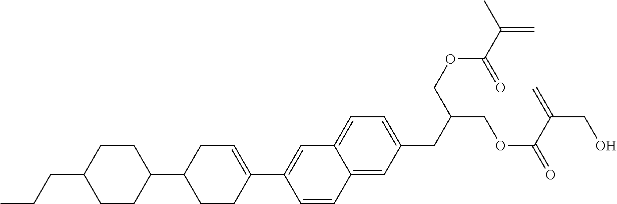 [SMILES: C=C(C)C(=O)OCC(COC(=O)C(=C)CO)Cc1ccc2cc(C3=CCC(C4CCC(CCC)CC4)CC3)ccc2c1] |
| 1ϵ-3-45 | 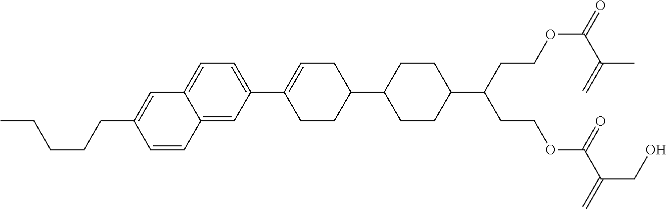 [SMILES: C=C(C)C(=O)OCCC(CCOC(=O)C(=C)CO)C1CCC(C2CC=C(c3ccc4cc(CCCCC)ccc4c3)CC2)CC1] |
| 1ϵ-3-46 | 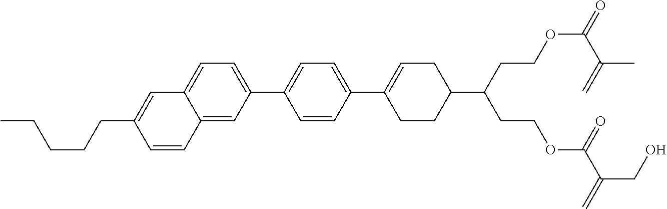 [SMILES: C=C(C)C(=O)OCCC(CCOC(=O)C(=C)CO)C1CC=C(c2ccc(-c3ccc4cc(CCCCC)ccc4c3)cc2)CC1] |
| 1ϵ-3-47 | 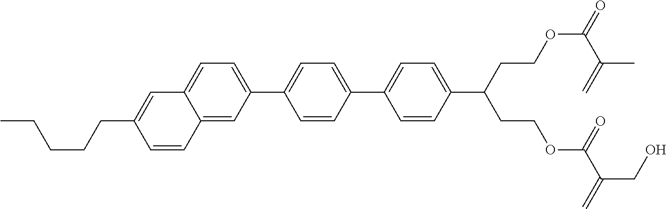 [SMILES: C=C(C)C(=O)OCCC(CCOC(=O)C(=C)CO)c1ccc(-c2ccc(-c3ccc4cc(CCCCC)ccc4c3)cc2)cc1] |
| 1ϵ-3-48 | 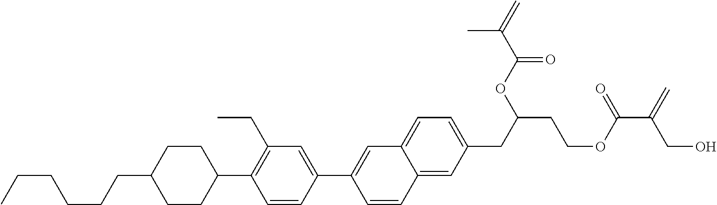 [SMILES: C=C(C)C(=O)OC(CCOC(=O)C(=C)CO)Cc1ccc2cc(-c3ccc(C4CCC(CCCCCC)CC4)c(CC)c3)ccc2c1] |
| 1ϵ-3-49 | 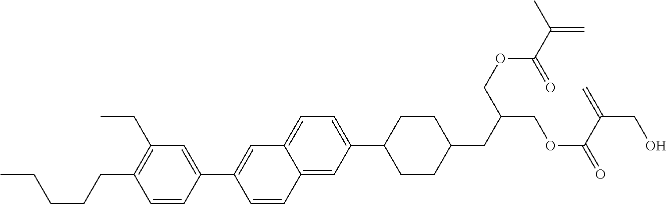 [SMILES: C=C(C)C(=O)OCC(COC(=O)C(=C)CO)CC1CCC(c2ccc3cc(-c4ccc(CCCCC)c(CC)c4)ccc3c2)CC1] |
| 1ϵ-3-50 | 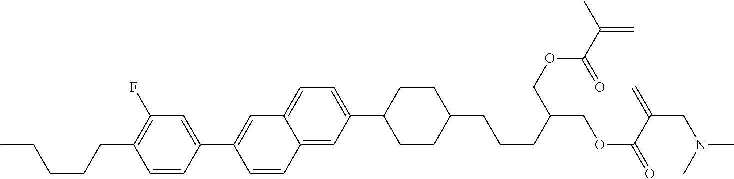 [SMILES: C=C(C)C(=O)OCC(CCCC1CCC(c2ccc3cc(-c4ccc(CCCCC)c(F)c4)ccc3c2)CC1)COC(=O)C(=C)CN(C)C] |
| 1ϵ-3-51 | 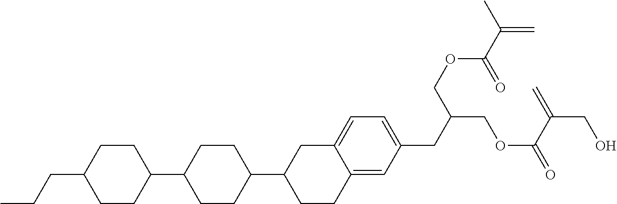 [SMILES: C=C(C)C(=O)OCC(COC(=O)C(=C)CO)Cc1ccc2c(c1)CCC(C1CCC(C3CCC(CCC)CC3)CC1)C2] |
| 1ϵ-3-52 | 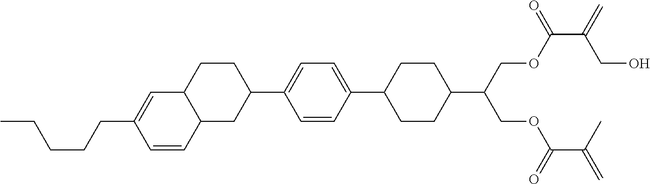 [SMILES: C=C(C)C(=O)OCC(COC(=O)C(=C)CO)C1CCC(c2ccc(C3CCC4C=C(CCCCC)C=CC4C3)cc2)CC1] |
| 1ϵ-3-53 | 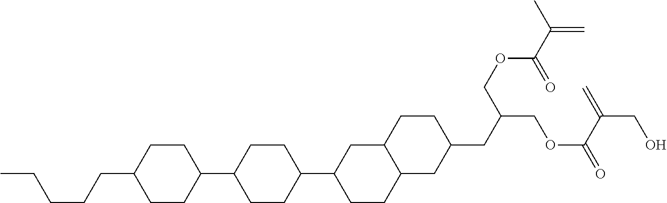 [SMILES: C=C(C)C(=O)OCC(COC(=O)C(=C)CO)CC1CCC2CC(C3CCC(C4CCC(CCCCC)CC4)CC3)CCC2C1] |
| 1ϵ-3-54 | 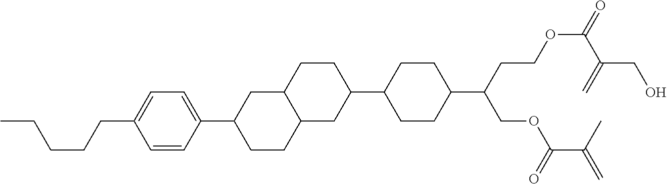 [SMILES: C=C(C)C(=O)OCC(CCOC(=O)C(=C)CO)C1CCC(C2CCC3CC(c4ccc(CCCCC)cc4)CCC3C2)CC1] |
| 1ϵ-3-55 | 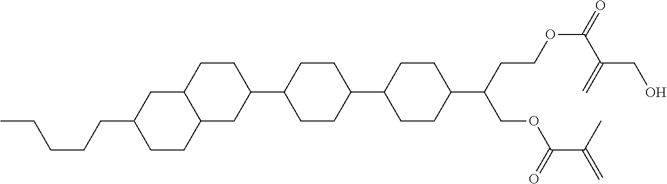 [SMILES: C=C(C)C(=O)OCC(CCOC(=O)C(=C)CO)C1CCC(C2CCC(C3CCC4CC(CCCCC)CCC4C3)CC2)CC1] |
| 1ϵ-3-56 | 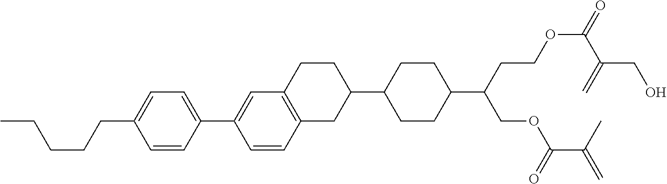 [SMILES: C=C(C)C(=O)OCC(CCOC(=O)C(=C)CO)C1CCC(C2CCc3cc(-c4ccc(CCCCC)cc4)ccc3C2)CC1] |
| 1ϵ-3-57 | 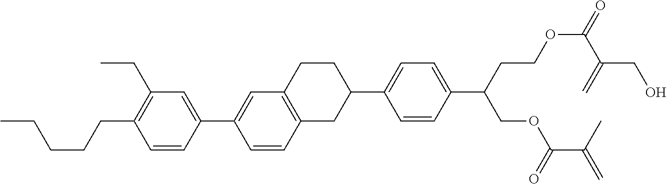 [SMILES: C=C(C)C(=O)OCC(CCOC(=O)C(=C)CO)c1ccc(C2CCc3cc(-c4ccc(CCCCC)c(CC)c4)ccc3C2)cc1] |
| 1ϵ-3-58 | 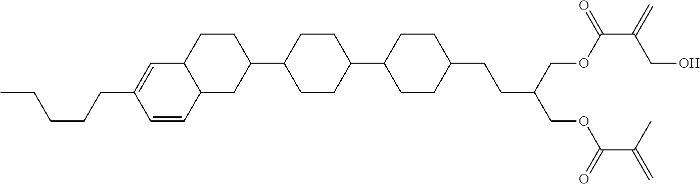 [SMILES: C=C(C)C(=O)OCC(CCC1CCC(C2CCC(C3CCC4C=C(CCCCC)C=CC4C3)CC2)CC1)COC(=O)C(=C)CO] |
| 1ϵ-3-59 | 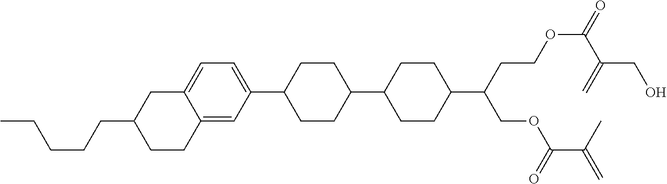 [SMILES: C=C(C)C(=O)OCC(CCOC(=O)C(=C)CO)C1CCC(C2CCC(c3ccc4c(c3)CCC(CCCCC)C4)CC2)CC1] |
| 1ϵ-3-60 | 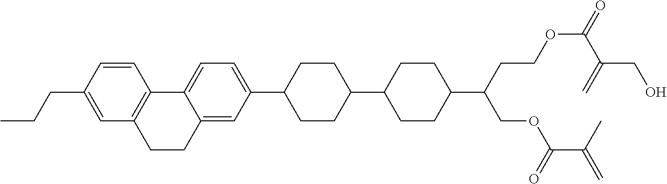 [SMILES: C=C(C)C(=O)OCC(CCOC(=O)C(=C)CO)C1CCC(C2CCC(c3ccc4c(c3)CCc3cc(CCC)ccc3-4)CC2)CC1] |
| 1ϵ-3-61 | 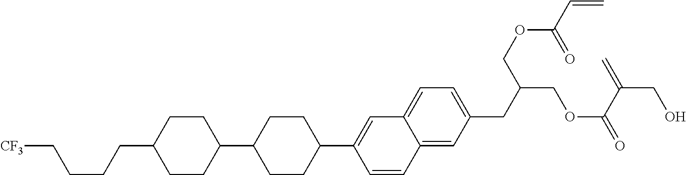 [SMILES: C=CC(=O)OCC(COC(=O)C(=C)CO)Cc1ccc2cc(C3CCC(C4CCC(CCCCC(F)(F)F)CC4)CC3)ccc2c1] |
| 1ϵ-3-62 | 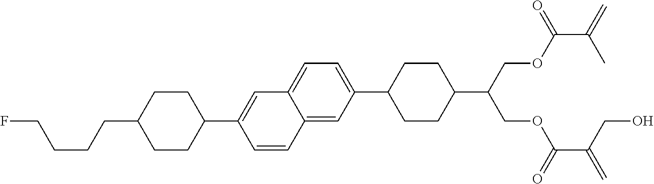 [SMILES: C=C(C)C(=O)OCC(COC(=O)C(=C)CO)C1CCC(c2ccc3cc(C4CCC(CCCCF)CC4)ccc3c2)CC1] |
| 1ϵ-3-63 | 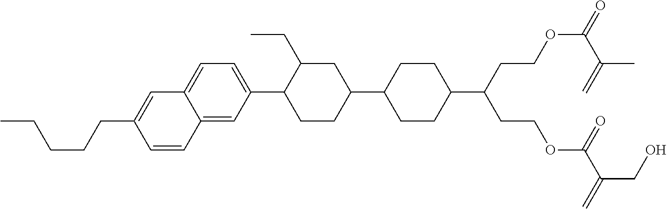 [SMILES: C=C(C)C(=O)OCCC(CCOC(=O)C(=C)CO)C1CCC(C2CCC(c3ccc4cc(CCCCC)ccc4c3)C(CC)C2)CC1] |
| 1ϵ-3-64 | 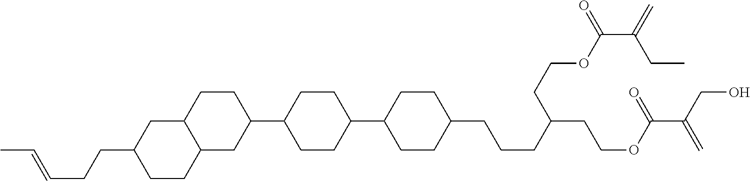 [SMILES: C=C(CC)C(=O)OCCC(CCCC1CCC(C2CCC(C3CCC4CC(CC/C=C/C)CCC4C3)CC2)CC1)CCOC(=O)C(=C)CO] |
| 1ϵ-3-65 | 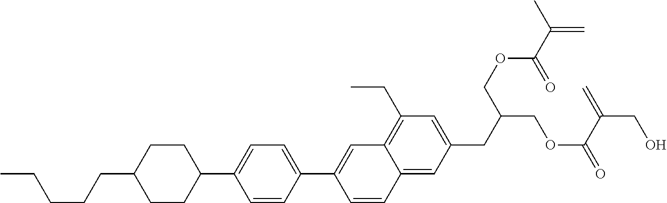 [SMILES: C=C(C)C(=O)OCC(COC(=O)C(=C)CO)Cc1cc(CC)c2cc(-c3ccc(C4CCC(CCCCC)CC4)cc3)ccc2c1] |
| 1ϵ-3-66 | 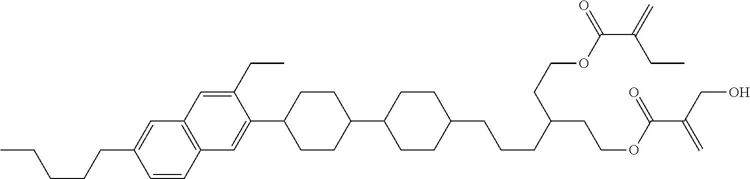 [SMILES: C=C(CC)C(=O)OCCC(CCCC1CCC(C2CCC(c3cc4ccc(CCCCC)cc4cc3CC)CC2)CC1)CCOC(=O)C(=C)CO] |
| 1ϵ-3-67 | 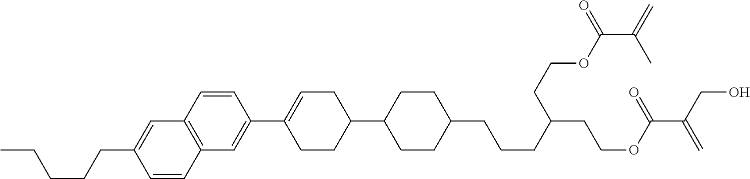 [SMILES: C=C(C)C(=O)OCCC(CCCC1CCC(C2CC=C(c3ccc4cc(CCCCC)ccc4c3)CC2)CC1)CCOC(=O)C(=C)CO] |
| 1ϵ-3-68 | 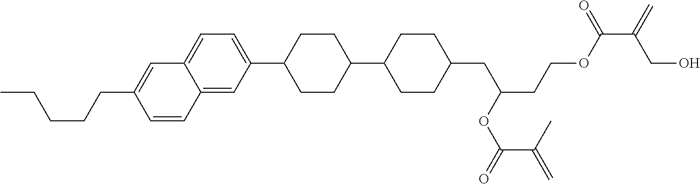 [SMILES: C=C(C)C(=O)OC(CCOC(=O)C(=C)CO)CC1CCC(C2CCC(c3ccc4cc(CCCCC)ccc4c3)CC2)CC1] |
| 1ϵ-3-69 | 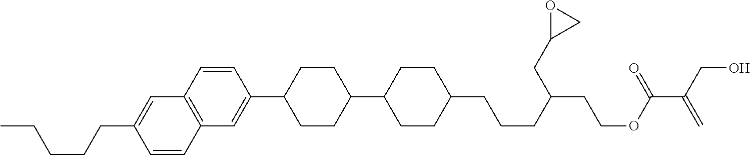 [SMILES: C=C(CO)C(=O)OCCC(CCCC1CCC(C2CCC(c3ccc4cc(CCCCC)ccc4c3)CC2)CC1)CC1CO1] |
| 1ϵ-3-70 | 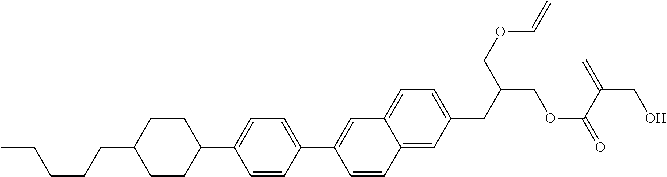 [SMILES: C=COCC(COC(=O)C(=C)CO)Cc1ccc2cc(-c3ccc(C4CCC(CCCCC)CC4)cc3)ccc2c1] |
| 1ϵ-3-71 | 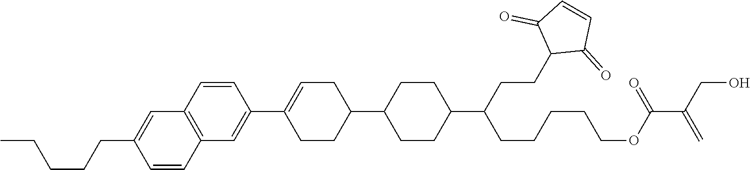 [SMILES: C=C(CO)C(=O)OCCCCCC(CCC1C(=O)C=CC1=O)C1CCC(C2CC=C(c3ccc4cc(CCCCC)ccc4c3)CC2)CC1] |
| 1ϵ-3-72 | 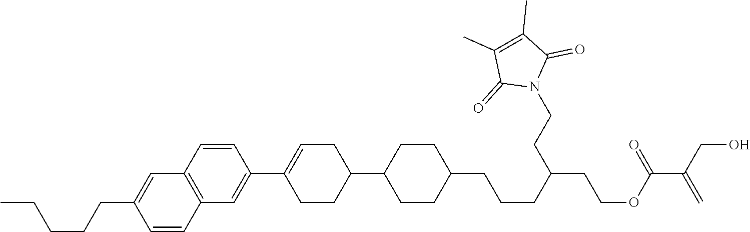 [SMILES: C=C(CO)C(=O)OCCC(CCCC1CCC(C2CC=C(c3ccc4cc(CCCCC)ccc4c3)CC2)CC1)CCN1C(=O)C(C)=C(C)C1=O] |
| 1ϵ-3-73 | 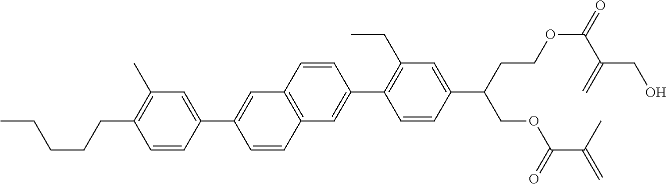 [SMILES: C=C(C)C(=O)OCC(CCOC(=O)C(=C)CO)c1ccc(-c2ccc3cc(-c4ccc(CCCCC)c(C)c4)ccc3c2)c(CC)c1] |
| 1ϵ-3-74 | 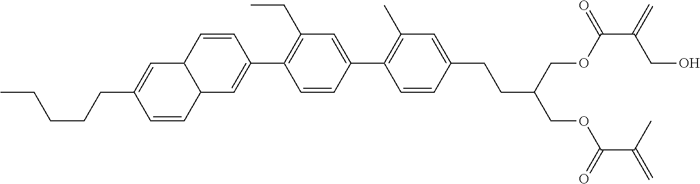 [SMILES: C=C(C)C(=O)OCC(CCc1ccc(-c2ccc(C3=CC4C=CC(CCCCC)=CC4C=C3)c(CC)c2)c(C)c1)COC(=O)C(=C)CO] |
| 1ϵ-3-75 | 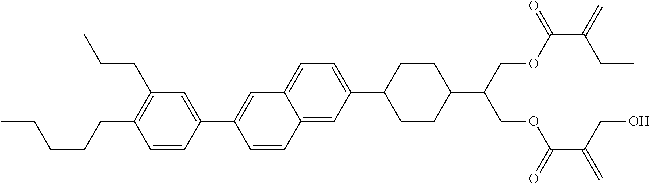 [SMILES: C=C(CC)C(=O)OCC(COC(=O)C(=C)CO)C1CCC(c2ccc3cc(-c4ccc(CCCCC)c(CCC)c4)ccc3c2)CC1] |
| 1ϵ-3-76 | 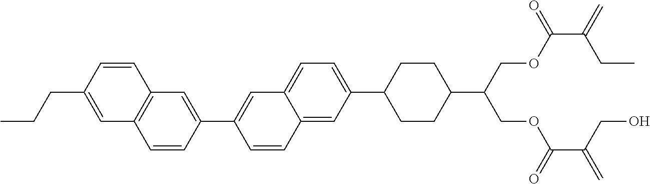 [SMILES: C=C(CC)C(=O)OCC(COC(=O)C(=C)CO)C1CCC(c2ccc3cc(-c4ccc5cc(CCC)ccc5c4)ccc3c2)CC1] |
| 1ϵ-3-77 | 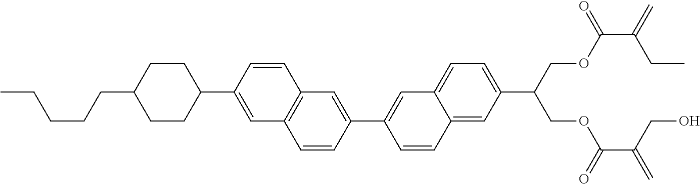 [SMILES: C=C(CC)C(=O)OCC(COC(=O)C(=C)CO)c1ccc2cc(-c3ccc4cc(C5CCC(CCCCC)CC5)ccc4c3)ccc2c1] |
| 1ϵ-3-78 | 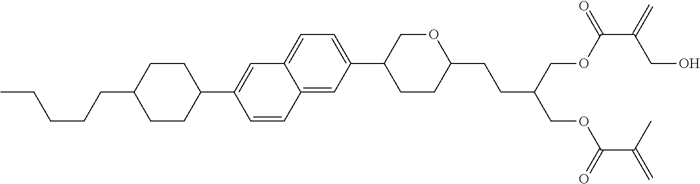 [SMILES: C=C(C)C(=O)OCC(CCC1CCC(c2ccc3cc(C4CCC(CCCCC)CC4)ccc3c2)CO1)COC(=O)C(=C)CO] |
| 1ϵ-3-79 | 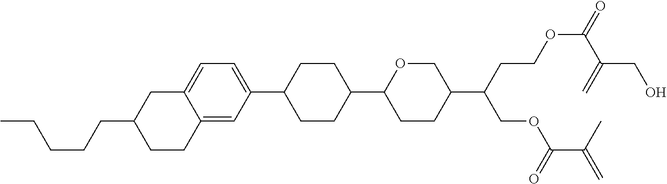 [SMILES: C=C(C)C(=O)OCC(CCOC(=O)C(=C)CO)C1CCC(C2CCC(c3ccc4c(c3)CCC(CCCCC)C4)CC2)OC1] |
| 1ϵ-3-80 | 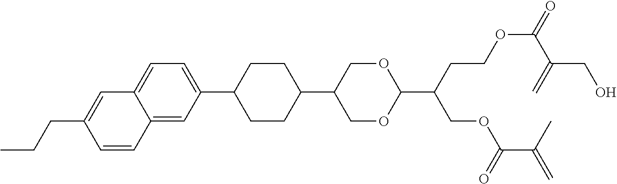 [SMILES: C=C(C)C(=O)OCC(CCOC(=O)C(=C)CO)C1OCC(C2CCC(c3ccc4cc(CCC)ccc4c3)CC2)CO1] |
| 1ϵ-3-81 | 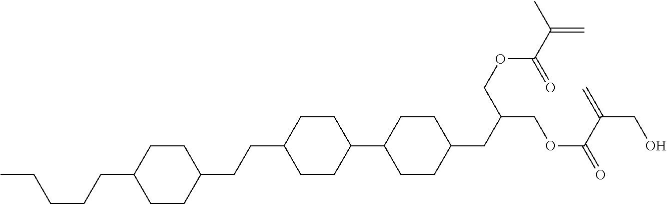 [SMILES: C=C(C)C(=O)OCC(COC(=O)C(=C)CO)CC1CCC(C2CCC(CCC3CCC(CCCCC)CC3)CC2)CC1] |
| 1ϵ-3-82 | 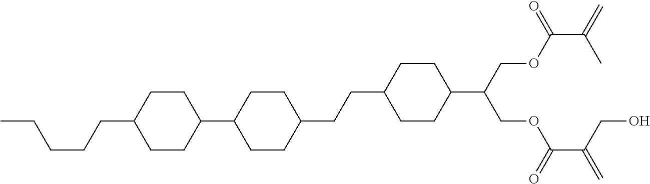 [SMILES: C=C(C)C(=O)OCC(COC(=O)C(=C)CO)C1CCC(CCC2CCC(C3CCC(CCCCC)CC3)CC2)CC1] |
| 1ϵ-3-83 | 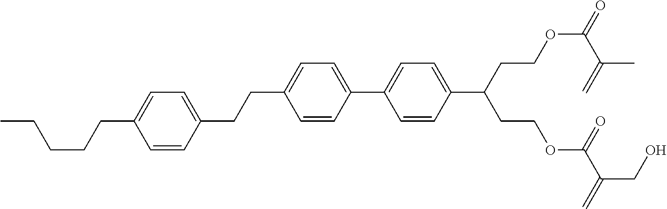 [SMILES: C=C(C)C(=O)OCCC(CCOC(=O)C(=C)CO)c1ccc(-c2ccc(CCc3ccc(CCCCC)cc3)cc2)cc1] |
| 1ϵ-3-84 | 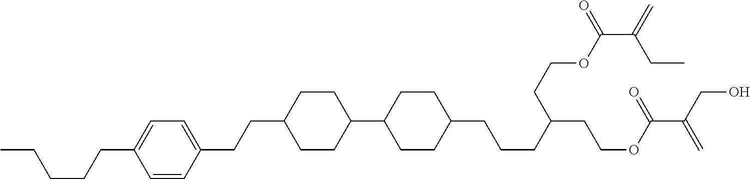 [SMILES: C=C(CC)C(=O)OCCC(CCCC1CCC(C2CCC(CCc3ccc(CCCCC)cc3)CC2)CC1)CCOC(=O)C(=C)CO] |
| 1ϵ-3-85 | 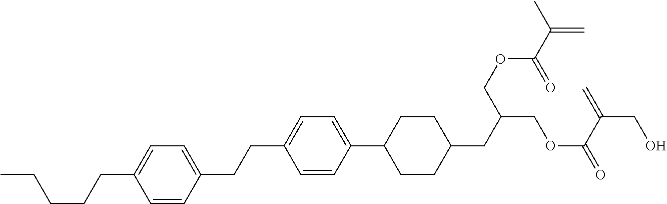 [SMILES: C=C(C)C(=O)OCC(COC(=O)C(=C)CO)CC1CCC(c2ccc(CCc3ccc(CCCCC)cc3)cc2)CC1] |
| 1ϵ-3-86 | 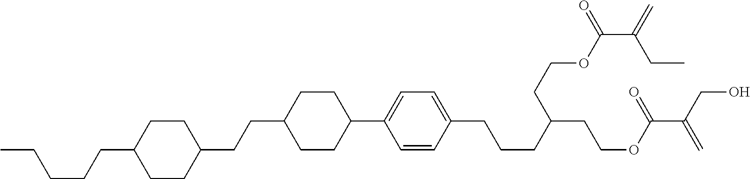 [SMILES: C=C(CC)C(=O)OCCC(CCCc1ccc(C2CCC(CCC3CCC(CCCCC)CC3)CC2)cc1)CCOC(=O)C(=C)CO] |
| 1ϵ-3-87 | 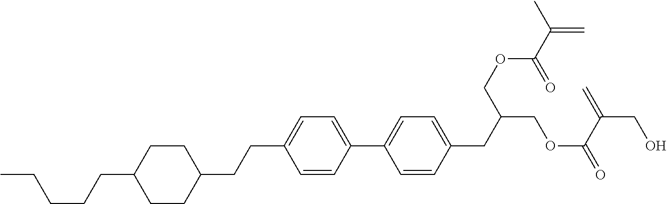 [SMILES: C=C(C)C(=O)OCC(COC(=O)C(=C)CO)Cc1ccc(-c2ccc(CCC3CCC(CCCCC)CC3)cc2)cc1] |
| 1ϵ-3-88 | 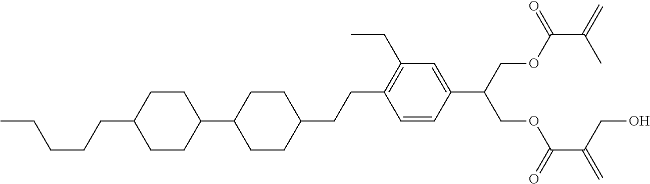 [SMILES: C=C(C)C(=O)OCC(COC(=O)C(=C)CO)c1ccc(CCC2CCC(C3CCC(CCCCC)CC3)CC2)c(CC)c1] |
| 1ϵ-3-89 | 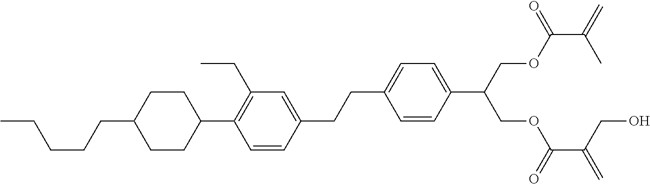 [SMILES: C=C(C)C(=O)OCC(COC(=O)C(=C)CO)c1ccc(CCc2ccc(C3CCC(CCCCC)CC3)c(CC)c2)cc1] |
| 1ϵ-3-90 | 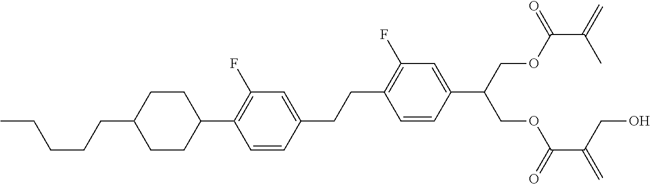 [SMILES: C=C(C)C(=O)OCC(COC(=O)C(=C)CO)c1ccc(CCc2ccc(C3CCC(CCCCC)CC3)c(F)c2)c(F)c1] |
| 1ϵ-3-91 | 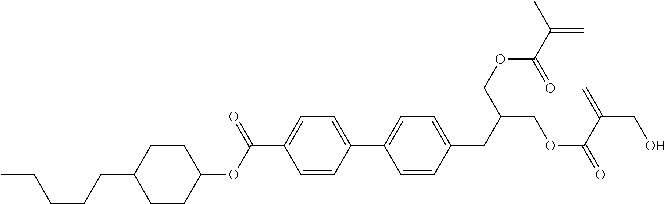 [SMILES: C=C(C)C(=O)OCC(COC(=O)C(=C)CO)Cc1ccc(-c2ccc(C(=O)OC3CCC(CCCCC)CC3)cc2)cc1] |
| 1ϵ-3-92 | 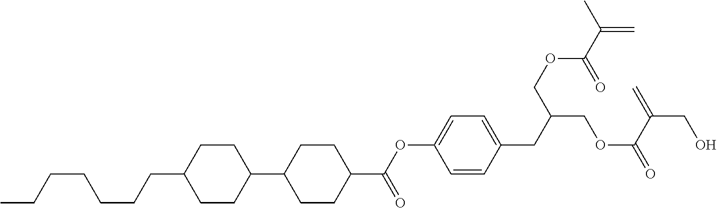 [SMILES: C=C(C)C(=O)OCC(COC(=O)C(=C)CO)Cc1ccc(OC(=O)C2CCC(C3CCC(CCCCCCC)CC3)CC2)cc1] |
| 1ϵ-3-93 | 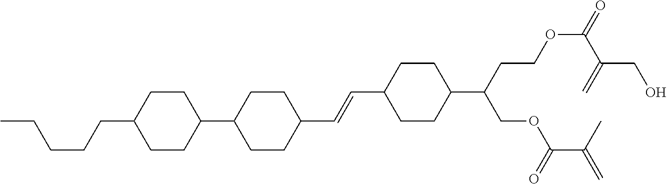 [SMILES: C=C(C)C(=O)OCC(CCOC(=O)C(=C)CO)C1CCC(/C=C/C2CCC(C3CCC(CCCCC)CC3)CC2)CC1] |
| 1ϵ-3-94 | 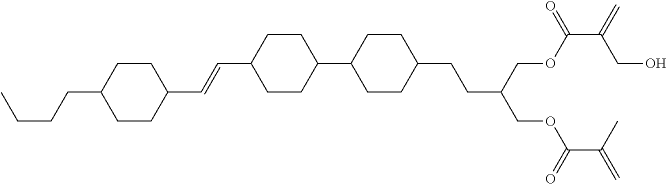 [SMILES: C=C(C)C(=O)OCC(CCC1CCC(C2CCC(/C=C/C3CCC(CCCC)CC3)CC2)CC1)COC(=O)C(=C)CO] |
| 1ϵ-3-95 | 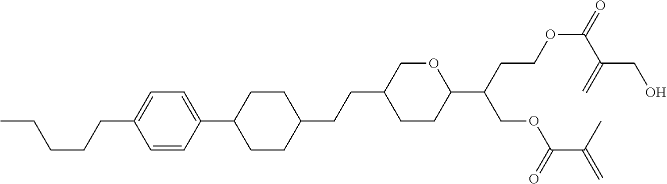 [SMILES: C=C(C)C(=O)OCC(CCOC(=O)C(=C)CO)C1CCC(CCC2CCC(c3ccc(CCCCC)cc3)CC2)CO1] |
| 1ϵ-3-96 | 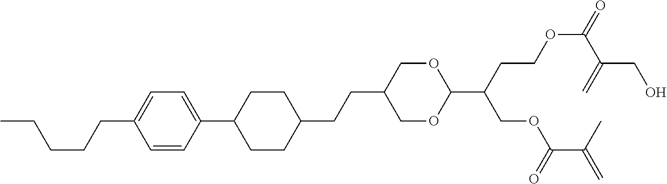 [SMILES: C=C(C)C(=O)OCC(CCOC(=O)C(=C)CO)C1OCC(CCC2CCC(c3ccc(CCCCC)cc3)CC2)CO1] |
| 1ϵ-3-97 | 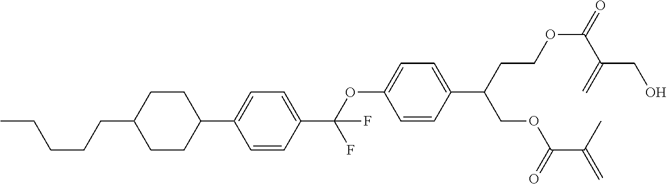 [SMILES: C=C(C)C(=O)OCC(CCOC(=O)C(=C)CO)c1ccc(OC(F)(F)c2ccc(C3CCC(CCCCC)CC3)cc2)cc1] |
| 1ϵ-3-98 | 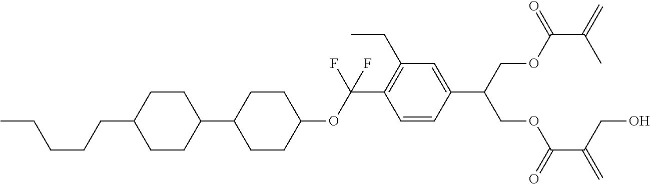 [SMILES: C=C(C)C(=O)OCC(COC(=O)C(=C)CO)c1ccc(C(F)(F)OC2CCC(C3CCC(CCCCC)CC3)CC2)c(CC)c1] |
| 1ϵ-3-99 | 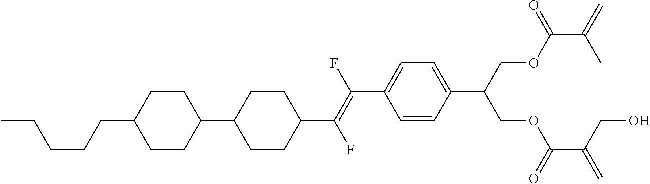 [SMILES: C=C(C)C(=O)OCC(COC(=O)C(=C)CO)c1ccc(/C(F)=C(\F)C2CCC(C3CCC(CCCCC)CC3)CC2)cc1] |
| 1ϵ-3-100 | 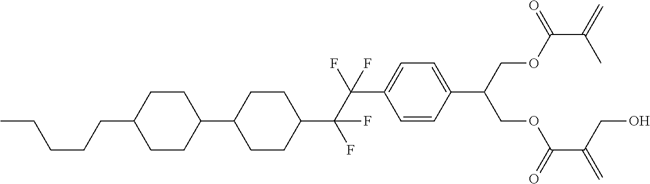 [SMILES: C=C(C)C(=O)OCC(COC(=O)C(=C)CO)c1ccc(C(F)(F)C(F)(F)C2CCC(C3CCC(CCCCC)CC3)CC2)cc1] |
| 1ϵ-3-101 | 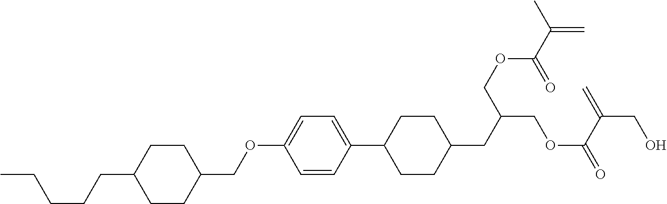 [SMILES: C=C(C)C(=O)OCC(COC(=O)C(=C)CO)CC1CCC(c2ccc(OCC3CCC(CCCCC)CC3)cc2)CC1] |
| 1ϵ-3-102 | 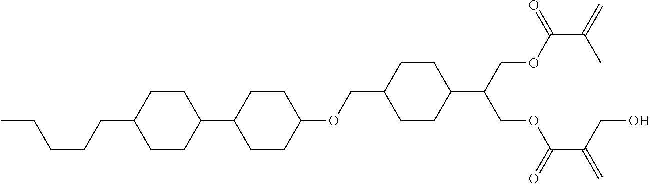 [SMILES: C=C(C)C(=O)OCC(COC(=O)C(=C)CO)C1CCC(COC2CCC(C3CCC(CCCCC)CC3)CC2)CC1] |
| 1ϵ-3-103 | 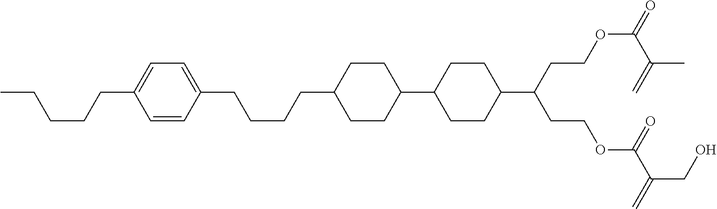 [SMILES: C=C(C)C(=O)OCCC(CCOC(=O)C(=C)CO)C1CCC(C2CCC(CCCCc3ccc(CCCCC)cc3)CC2)CC1] |
| 1ϵ-3-104 | 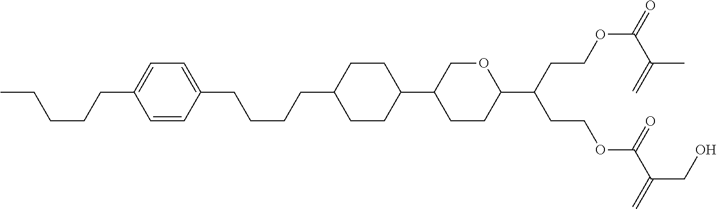 [SMILES: C=C(C)C(=O)OCCC(CCOC(=O)C(=C)CO)C1CCC(C2CCC(CCCCc3ccc(CCCCC)cc3)CC2)CO1] |
| 1ϵ-3-105 | 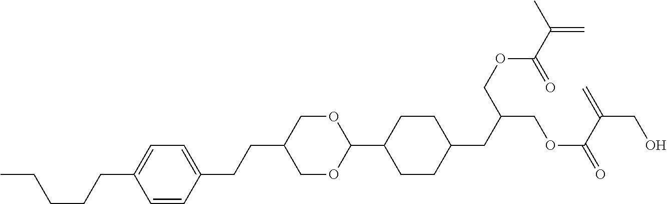 [SMILES: C=C(C)C(=O)OCC(COC(=O)C(=C)CO)CC1CCC(C2OCC(CCc3ccc(CCCCC)cc3)CO2)CC1] |
| 1ϵ-3-106 | 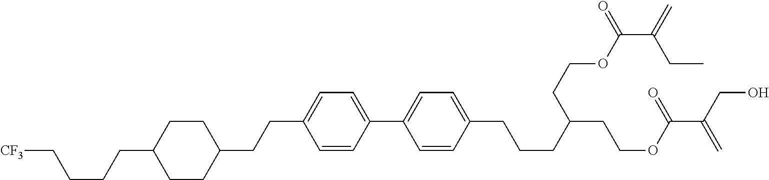 [SMILES: C=C(CC)C(=O)OCCC(CCCc1ccc(-c2ccc(CCC3CCC(CCCCC(F)(F)F)CC3)cc2)cc1)CCOC(=O)C(=C)CO] |
| 1ϵ-3-107 | 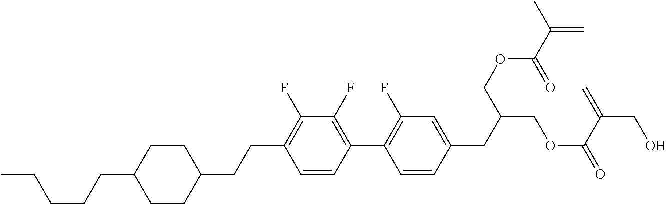 [SMILES: C=C(C)C(=O)OCC(COC(=O)C(=C)CO)Cc1ccc(-c2ccc(CCC3CCC(CCCCC)CC3)c(F)c2F)c(F)c1] |
| 1ϵ-3-108 | 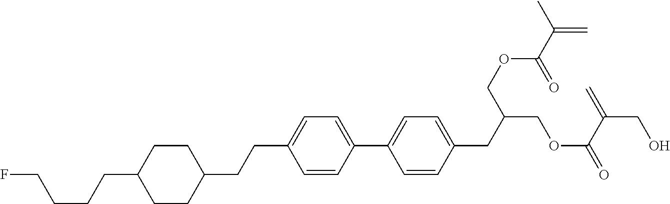 [SMILES: C=C(C)C(=O)OCC(COC(=O)C(=C)CO)Cc1ccc(-c2ccc(CCC3CCC(CCCCF)CC3)cc2)cc1] |
| 1ϵ-3-109 | 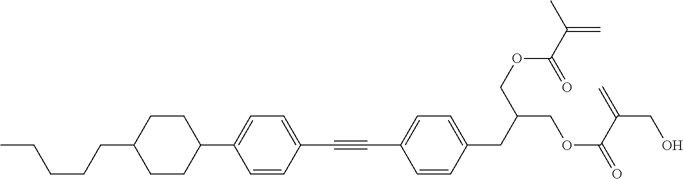 [SMILES: C=C(C)C(=O)OCC(COC(=O)C(=C)CO)Cc1ccc(C#Cc2ccc(C3CCC(CCCCC)CC3)cc2)cc1] |
| 1ϵ-3-110 | 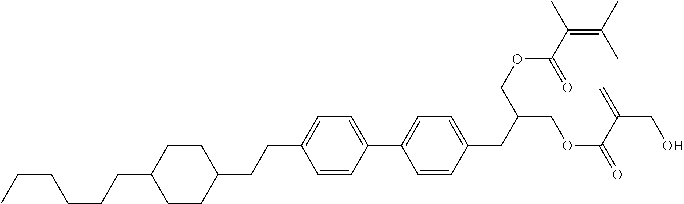 [SMILES: C=C(CO)C(=O)OCC(COC(=O)C(C)=C(C)C)Cc1ccc(-c2ccc(CCC3CCC(CCCCCC)CC3)cc2)cc1] |
| 1ϵ-3-111 | 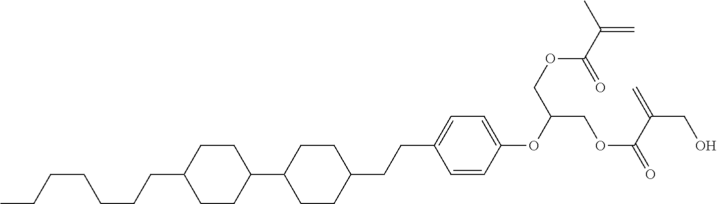 [SMILES: C=C(C)C(=O)OCC(COC(=O)C(=C)CO)Oc1ccc(CCC2CCC(C3CCC(CCCCCCC)CC3)CC2)cc1] |
| 1ϵ-3-112 | 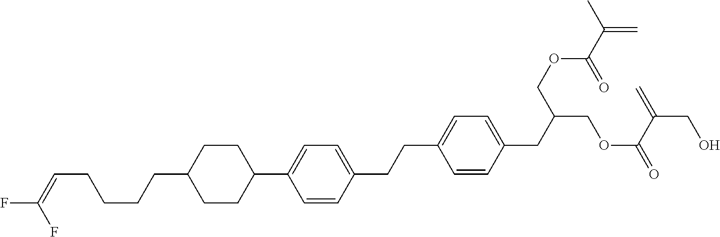 [SMILES: C=C(C)C(=O)OCC(COC(=O)C(=C)CO)Cc1ccc(CCc2ccc(C3CCC(CCCCC=C(F)F)CC3)cc2)cc1] |
| 1ϵ-3-113 | 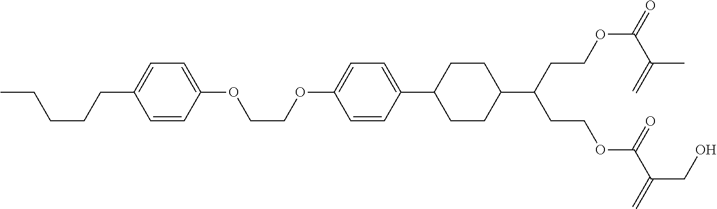 [SMILES: C=C(C)C(=O)OCCC(CCOC(=O)C(=C)CO)C1CCC(c2ccc(OCCOc3ccc(CCCCC)cc3)cc2)CC1] |
| 1ϵ-3-114 | 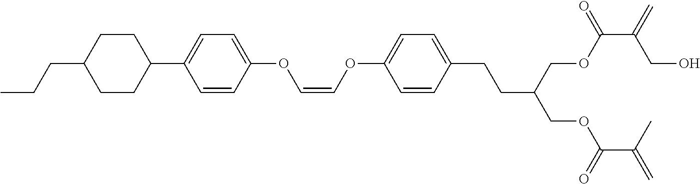 [SMILES: C=C(C)C(=O)OCC(CCc1ccc(O/C=C\Oc2ccc(C3CCC(CCC)CC3)cc2)cc1)COC(=O)C(=C)CO] |
| 1ϵ-3-115 | 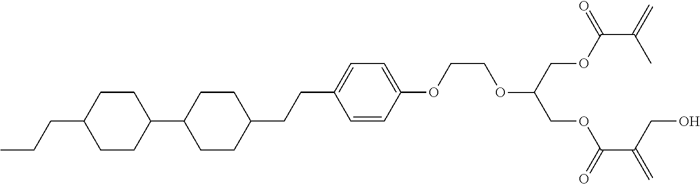 [SMILES: C=C(C)C(=O)OCC(COC(=O)C(=C)CO)OCCOc1ccc(CCC2CCC(C3CCC(CCC)CC3)CC2)cc1] |
| 1ϵ-3-116 | 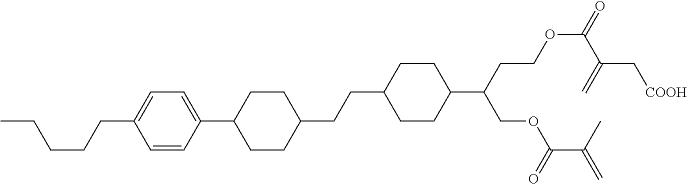 [SMILES: C=C(C)C(=O)OCC(CCOC(=O)C(=C)CC(=O)O)C1CCC(CCC2CCC(c3ccc(CCCCC)cc3)CC2)CC1] |
| 1ϵ-3-117 | 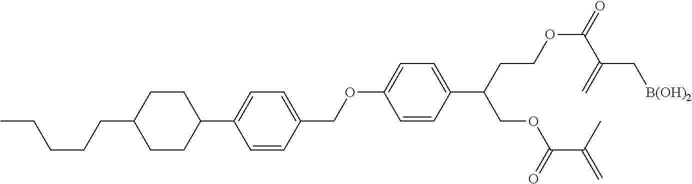 [SMILES: C=C(C)C(=O)OCC(CCOC(=O)C(=C)CB(O)O)c1ccc(OCc2ccc(C3CCC(CCCCC)CC3)cc2)cc1] |
| 1ϵ-3-118 | 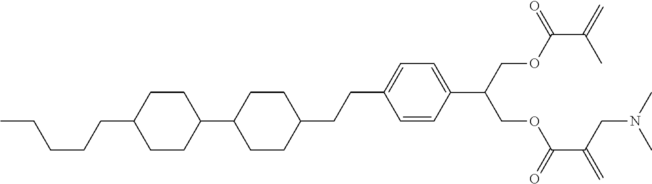 [SMILES: C=C(C)C(=O)OCC(COC(=O)C(=C)CN(C)C)c1ccc(CCC2CCC(C3CCC(CCCCC)CC3)CC2)cc1] |
| 1ϵ-3-119 | 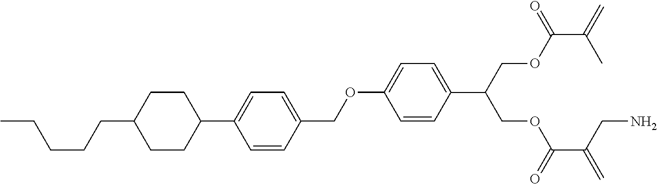 [SMILES: C=C(C)C(=O)OCC(COC(=O)C(=C)CN)c1ccc(OCc2ccc(C3CCC(CCCCC)CC3)cc2)cc1] |
| 1ϵ-3-120 | 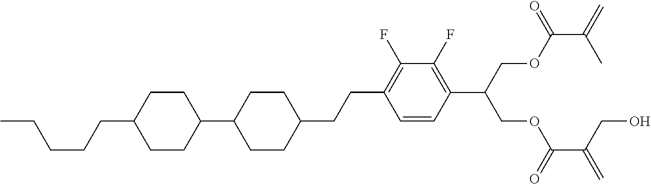 [SMILES: C=C(C)C(=O)OCC(COC(=O)C(=C)CO)c1ccc(CCC2CCC(C3CCC(CCCCC)CC3)CC2)c(F)c1F] |
| 1ϵ-3-121 | 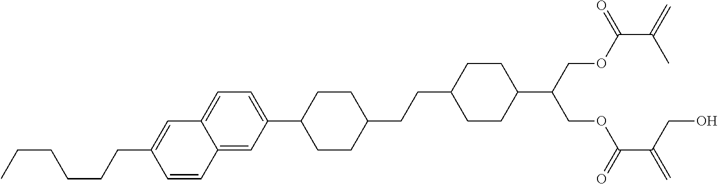 [SMILES: C=C(C)C(=O)OCC(COC(=O)C(=C)CO)C1CCC(CCC2CCC(c3ccc4cc(CCCCCC)ccc4c3)CC2)CC1] |
| 1ϵ-3-122 | 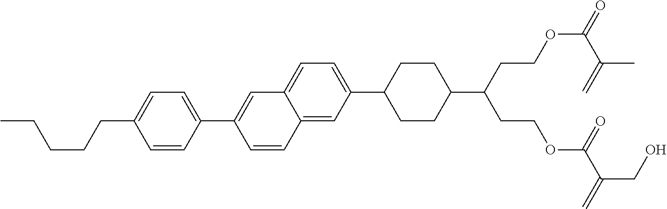 [SMILES: C=C(C)C(=O)OCCC(CCOC(=O)C(=C)CO)C1CCC(c2ccc3cc(-c4ccc(CCCCC)cc4)ccc3c2)CC1] |
| 1ϵ-3-123 | 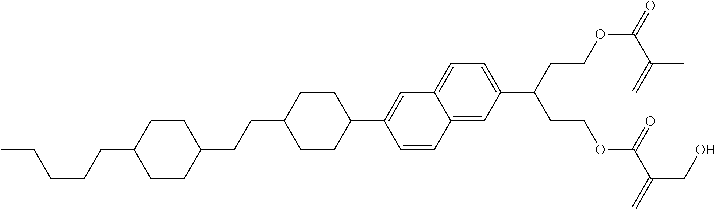 [SMILES: C=C(C)C(=O)OCCC(CCOC(=O)C(=C)CO)c1ccc2cc(C3CCC(CCC4CCC(CCCCC)CC4)CC3)ccc2c1] |
| 1ϵ-3-124 | 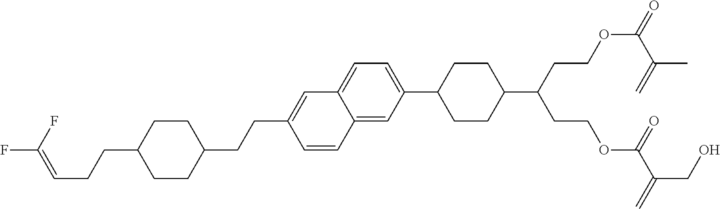 [SMILES: C=C(C)C(=O)OCCC(CCOC(=O)C(=C)CO)C1CCC(c2ccc3cc(CCC4CCC(CCC=C(F)F)CC4)ccc3c2)CC1] |
| 1ϵ-3-125 | 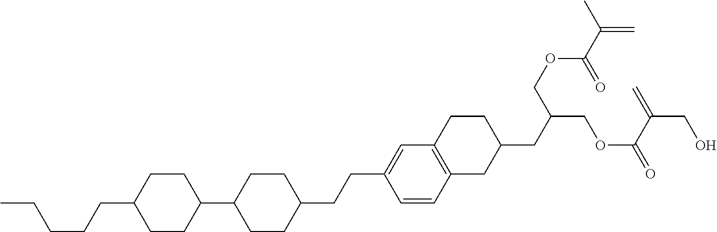 [SMILES: C=C(C)C(=O)OCC(COC(=O)C(=C)CO)CC1CCc2cc(CCC3CCC(C4CCC(CCCCC)CC4)CC3)ccc2C1] |
| 1ϵ-3-126 | 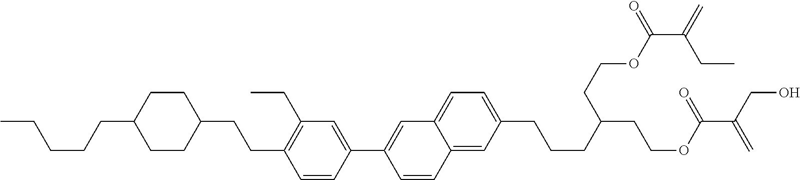 [SMILES: C=C(CC)C(=O)OCCC(CCCc1ccc2cc(-c3ccc(CCC4CCC(CCCCC)CC4)c(CC)c3)ccc2c1)CCOC(=O)C(=C)CO] |
| 1ϵ-3-127 | 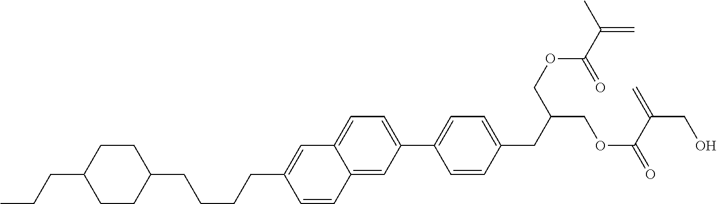 [SMILES: C=C(C)C(=O)OCC(COC(=O)C(=C)CO)Cc1ccc(-c2ccc3cc(CCCCC4CCC(CCC)CC4)ccc3c2)cc1] |
| 1ϵ-3-128 | 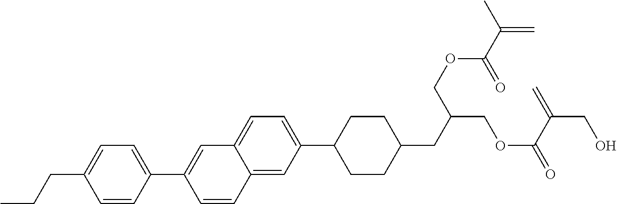 [SMILES: C=C(C)C(=O)OCC(COC(=O)C(=C)CO)CC1CCC(c2ccc3cc(-c4ccc(CCC)cc4)ccc3c2)CC1] |
| 1ϵ-3-129 | 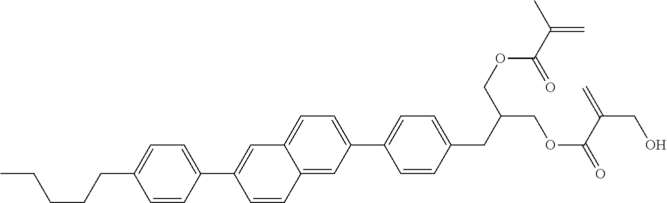 [SMILES: C=C(C)C(=O)OCC(COC(=O)C(=C)CO)Cc1ccc(-c2ccc3cc(-c4ccc(CCCCC)cc4)ccc3c2)cc1] |
| 1ϵ-3-130 | 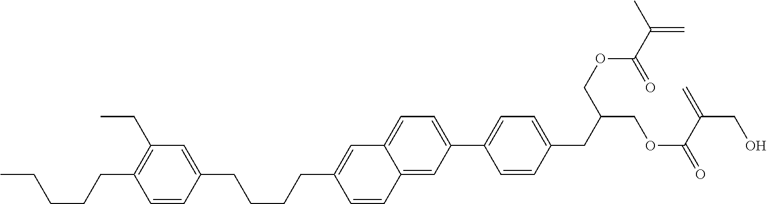 [SMILES: C=C(C)C(=O)OCC(COC(=O)C(=C)CO)Cc1ccc(-c2ccc3cc(CCCCc4ccc(CCCCC)c(CC)c4)ccc3c2)cc1] |
| 1ϵ-3-131 | 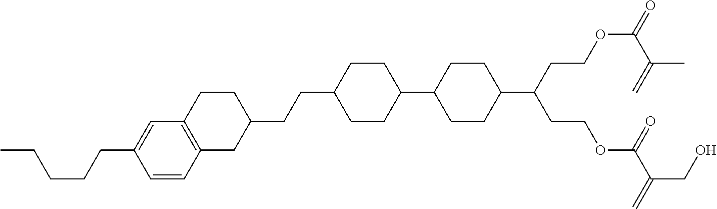 [SMILES: C=C(C)C(=O)OCCC(CCOC(=O)C(=C)CO)C1CCC(C2CCC(CCC3CCc4cc(CCCCC)ccc4C3)CC2)CC1] |
| 1ϵ-3-132 | 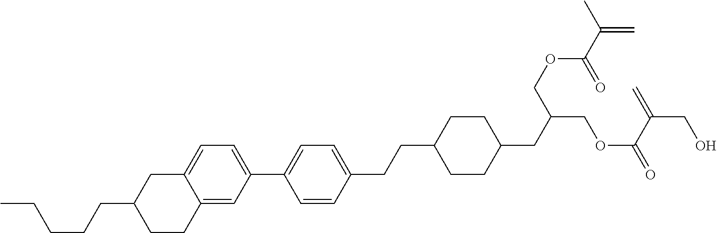 [SMILES: C=C(C)C(=O)OCC(COC(=O)C(=C)CO)CC1CCC(CCc2ccc(-c3ccc4c(c3)CCC(CCCCC)C4)cc2)CC1] |
| 1ϵ-3-133 | 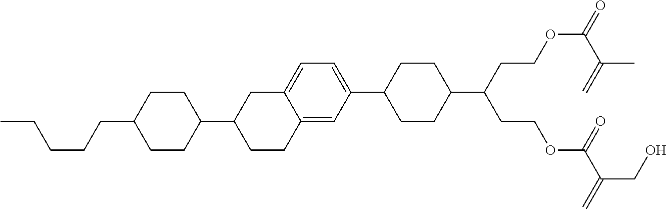 [SMILES: C=C(C)C(=O)OCCC(CCOC(=O)C(=C)CO)C1CCC(c2ccc3c(c2)CCC(C2CCC(CCCCC)CC2)C3)CC1] |
| 1ϵ-3-134 | 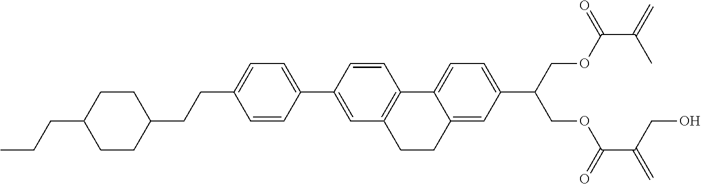 [SMILES: C=C(C)C(=O)OCC(COC(=O)C(=C)CO)c1ccc2c(c1)CCc1cc(-c3ccc(CCC4CCC(CCC)CC4)cc3)ccc1-2] |
| 1ϵ-3-135 | 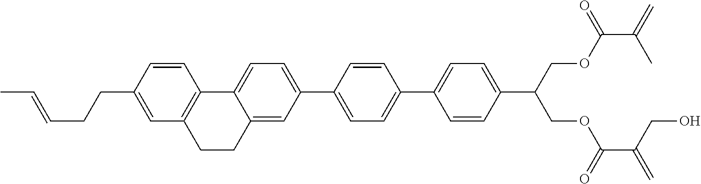 [SMILES: C=C(C)C(=O)OCC(COC(=O)C(=C)CO)c1ccc(-c2ccc(-c3ccc4c(c3)CCc3cc(CC/C=C/C)ccc3-4)cc2)cc1] |
| 1ϵ-3-136 | 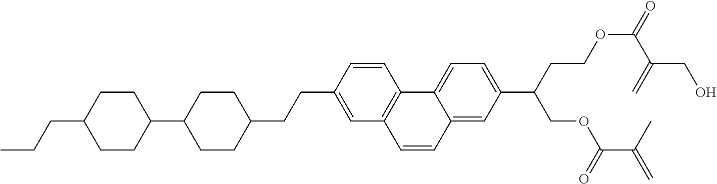 [SMILES: C=C(C)C(=O)OCC(CCOC(=O)C(=C)CO)c1ccc2c(ccc3cc(CCC4CCC(C5CCC(CCC)CC5)CC4)ccc32)c1] |
| 1ϵ-3-137 | 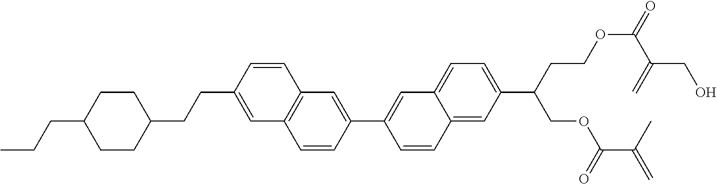 [SMILES: C=C(C)C(=O)OCC(CCOC(=O)C(=C)CO)c1ccc2cc(-c3ccc4cc(CCC5CCC(CCC)CC5)ccc4c3)ccc2c1] |
| 1ϵ-3-138 | 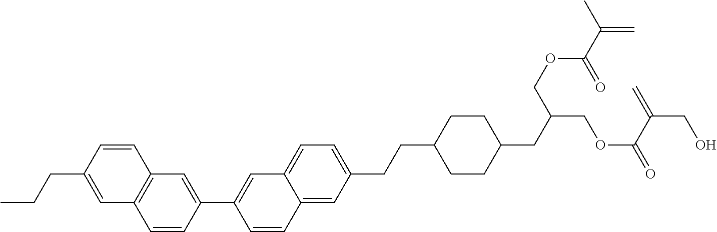 [SMILES: C=C(C)C(=O)OCC(COC(=O)C(=C)CO)CC1CCC(CCc2ccc3cc(-c4ccc5cc(CCC)ccc5c4)ccc3c2)CC1] |
| 1ϵ-3-139 | 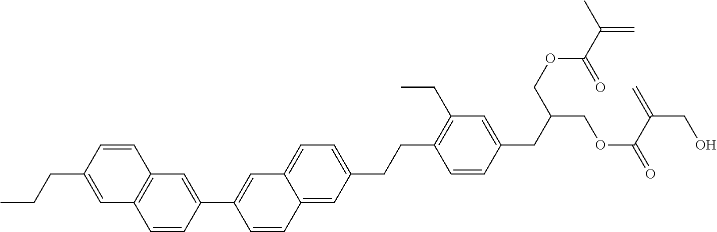 [SMILES: C=C(C)C(=O)OCC(COC(=O)C(=C)CO)Cc1ccc(CCc2ccc3cc(-c4ccc5cc(CCC)ccc5c4)ccc3c2)c(CC)c1] |
| 1ϵ-3-140 | 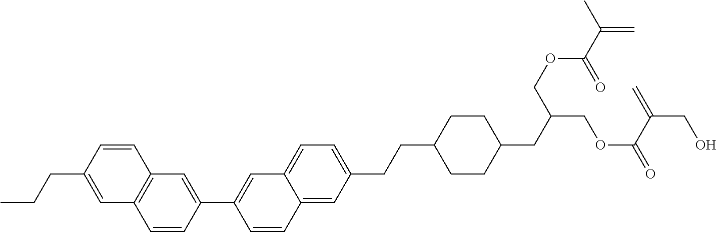 [SMILES: C=C(C)C(=O)OCC(COC(=O)C(=C)CO)CC1CCC(CCc2ccc3cc(-c4ccc5cc(CCC)ccc5c4)ccc3c2)CC1] |
| 1ϵ-4-1 | 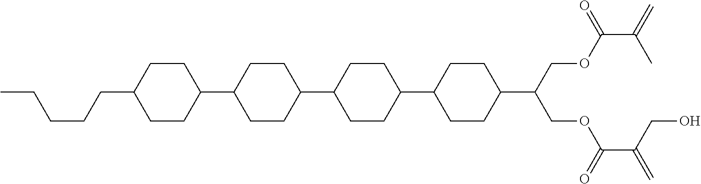 [SMILES: C=C(C)C(=O)OCC(COC(=O)C(=C)CO)C1CCC(C2CCC(C3CCC(C4CCC(CCCCC)CC4)CC3)CC2)CC1] |
| 1ϵ-4-2 | 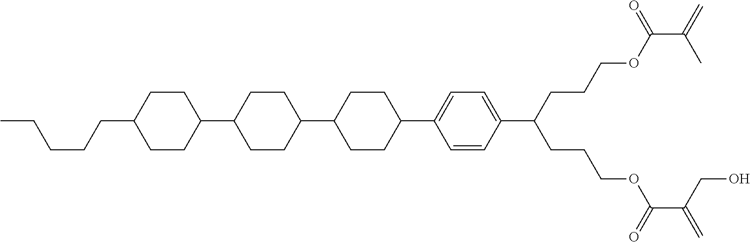 [SMILES: C=C(C)C(=O)OCCCC(CCCOC(=O)C(=C)CO)c1ccc(C2CCC(C3CCC(C4CCC(CCCCC)CC4)CC3)CC2)cc1] |
| 1ϵ-4-3 | 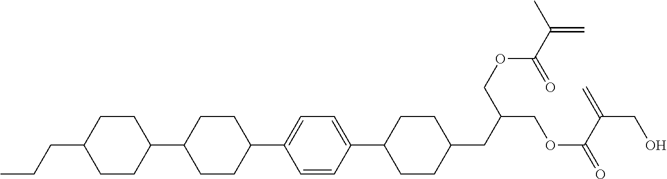 [SMILES: C=C(C)C(=O)OCC(COC(=O)C(=C)CO)CC1CCC(c2ccc(C3CCC(C4CCC(CCC)CC4)CC3)cc2)CC1] |
| 1ϵ-4-4 | 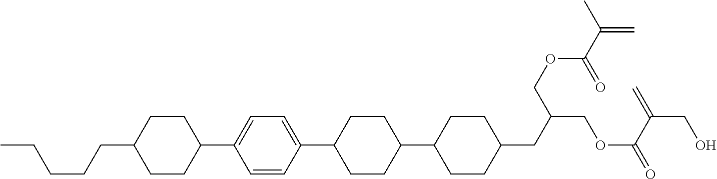 [SMILES: C=C(C)C(=O)OCC(COC(=O)C(=C)CO)CC1CCC(C2CCC(c3ccc(C4CCC(CCCCC)CC4)cc3)CC2)CC1] |
| 1ϵ-4-5 | 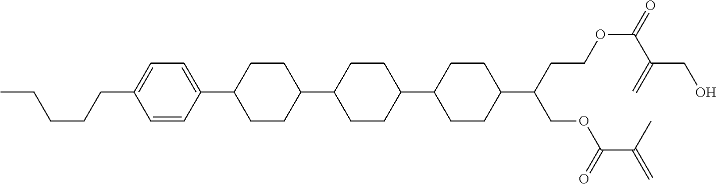 [SMILES: C=C(C)C(=O)OCC(CCOC(=O)C(=C)CO)C1CCC(C2CCC(C3CCC(c4ccc(CCCCC)cc4)CC3)CC2)CC1] |
| 1ϵ-4-6 | 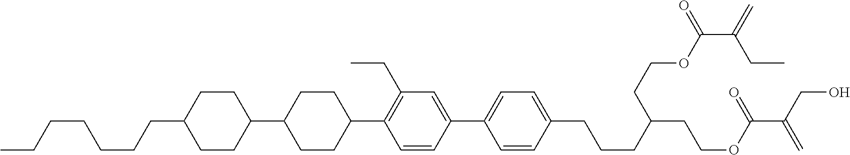 [SMILES: C=C(CC)C(=O)OCCC(CCCc1ccc(-c2ccc(C3CCC(C4CCC(CCCCCCC)CC4)CC3)c(CC)c2)cc1)CCOC(=O)C(=C)CO] |
| 1ϵ-4-7 | 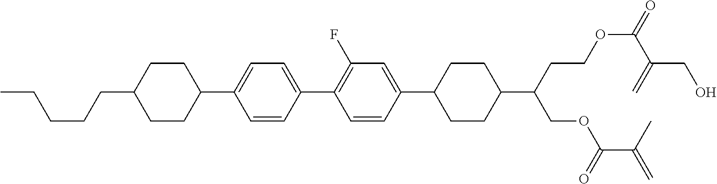 [SMILES: C=C(C)C(=O)OCC(CCOC(=O)C(=C)CO)C1CCC(c2ccc(-c3ccc(C4CCC(CCCCC)CC4)cc3)c(F)c2)CC1] |
| 1ϵ-4-8 | 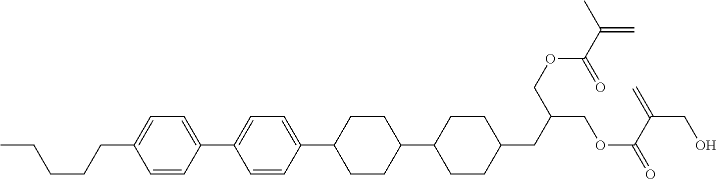 [SMILES: C=C(C)C(=O)OCC(COC(=O)C(=C)CO)CC1CCC(C2CCC(c3ccc(-c4ccc(CCCCC)cc4)cc3)CC2)CC1] |
| 1ϵ-4-9 | 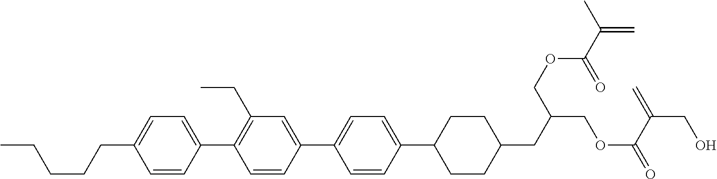 [SMILES: C=C(C)C(=O)OCC(COC(=O)C(=C)CO)CC1CCC(c2ccc(-c3ccc(-c4ccc(CCCCC)cc4)c(CC)c3)cc2)CC1] |
| 1ϵ-4-10 | 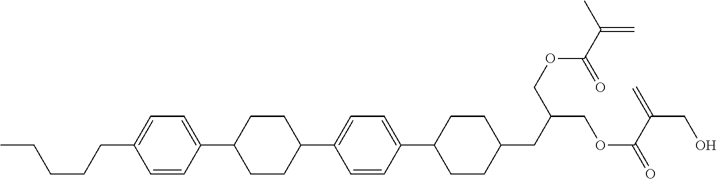 [SMILES: C=C(C)C(=O)OCC(COC(=O)C(=C)CO)CC1CCC(c2ccc(C3CCC(c4ccc(CCCCC)cc4)CC3)cc2)CC1] |
| 1ϵ-4-11 | 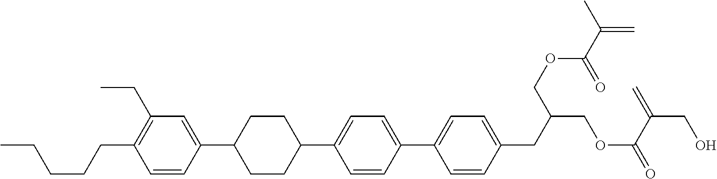 [SMILES: C=C(C)C(=O)OCC(COC(=O)C(=C)CO)Cc1ccc(-c2ccc(C3CCC(c4ccc(CCCCC)c(CC)c4)CC3)cc2)cc1] |
| 1ϵ-4-12 | 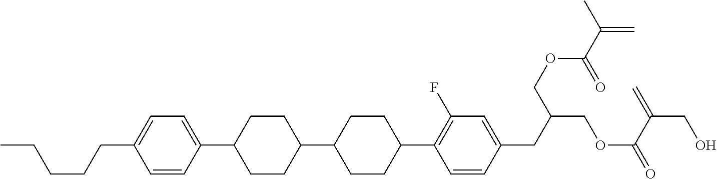 [SMILES: C=C(C)C(=O)OCC(COC(=O)C(=C)CO)Cc1ccc(C2CCC(C3CCC(c4ccc(CCCCC)cc4)CC3)CC2)c(F)c1] |
| 1ϵ-4-13 | 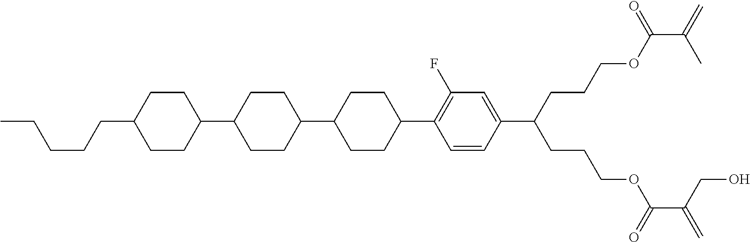 [SMILES: C=C(C)C(=O)OCCCC(CCCOC(=O)C(=C)CO)c1ccc(C2CCC(C3CCC(C4CCC(CCCCC)CC4)CC3)CC2)c(F)c1] |
| 1ϵ-4-14 | 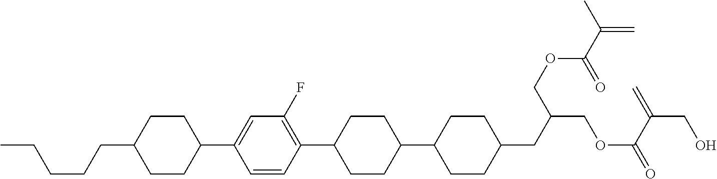 [SMILES: C=C(C)C(=O)OCC(COC(=O)C(=C)CO)CC1CCC(C2CCC(c3ccc(C4CCC(CCCCC)CC4)cc3F)CC2)CC1] |
| 1ϵ-4-15 | 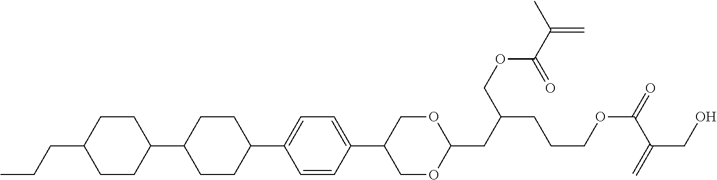 [SMILES: C=C(C)C(=O)OCC(CCCOC(=O)C(=C)CO)CC1OCC(c2ccc(C3CCC(C4CCC(CCC)CC4)CC3)cc2)CO1] |
| 1ϵ-4-16 | 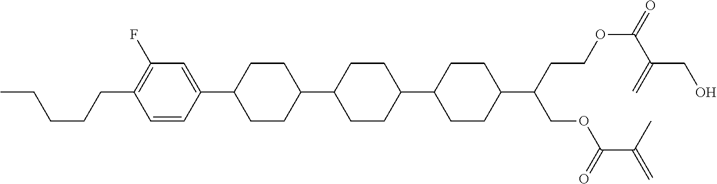 [SMILES: C=C(C)C(=O)OCC(CCOC(=O)C(=C)CO)C1CCC(C2CCC(C3CCC(c4ccc(CCCCC)c(F)c4)CC3)CC2)CC1] |
| 1ϵ-4-17 | 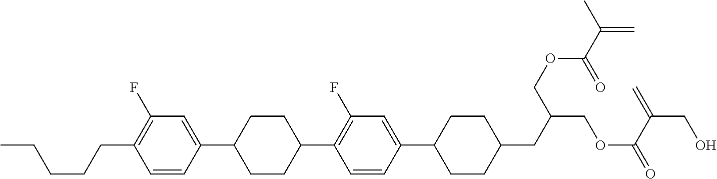 [SMILES: C=C(C)C(=O)OCC(COC(=O)C(=C)CO)CC1CCC(c2ccc(C3CCC(c4ccc(CCCCC)c(F)c4)CC3)c(F)c2)CC1] |
| 1ϵ-4-18 | 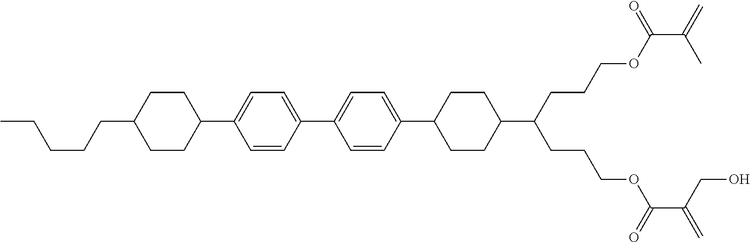 [SMILES: C=C(C)C(=O)OCCCC(CCCOC(=O)C(=C)CO)C1CCC(c2ccc(-c3ccc(C4CCC(CCCCC)CC4)cc3)cc2)CC1] |
| 1ϵ-4-19 | 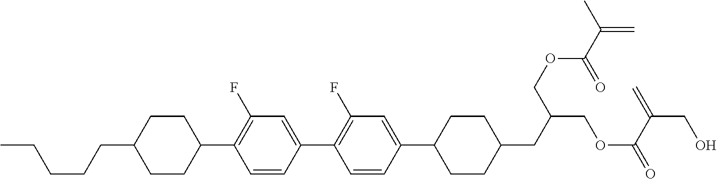 [SMILES: C=C(C)C(=O)OCC(COC(=O)C(=C)CO)CC1CCC(c2ccc(-c3ccc(C4CCC(CCCCC)CC4)c(F)c3)c(F)c2)CC1] |
| 1ϵ-4-20 | 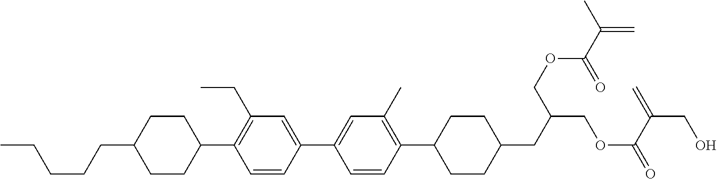 [SMILES: C=C(C)C(=O)OCC(COC(=O)C(=C)CO)CC1CCC(c2ccc(-c3ccc(C4CCC(CCCCC)CC4)c(CC)c3)cc2C)CC1] |
| 1ϵ-4-21 | 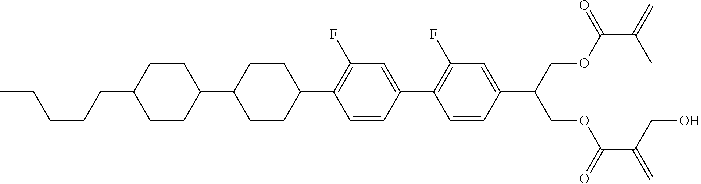 [SMILES: C=C(C)C(=O)OCC(COC(=O)C(=C)CO)c1ccc(-c2ccc(C3CCC(C4CCC(CCCCC)CC4)CC3)c(F)c2)c(F)c1] |
| 1ϵ-4-22 | 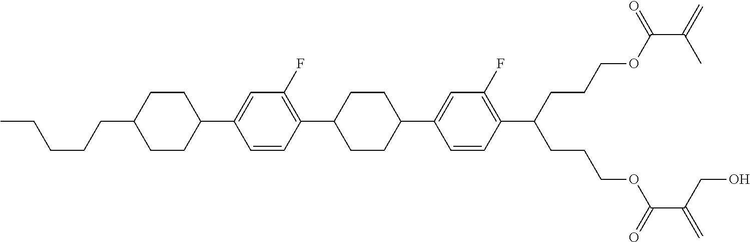 [SMILES: C=C(C)C(=O)OCCCC(CCCOC(=O)C(=C)CO)c1ccc(C2CCC(c3ccc(C4CCC(CCCCC)CC4)cc3F)CC2)cc1F] |
| 1ϵ-4-23 | 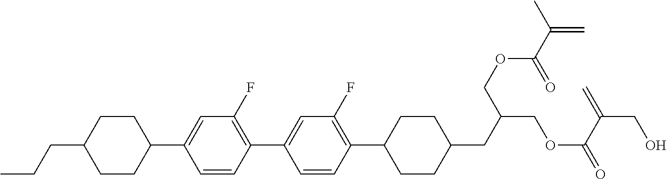 [SMILES: C=C(C)C(=O)OCC(COC(=O)C(=C)CO)CC1CCC(c2ccc(-c3ccc(C4CCC(CCC)CC4)cc3F)cc2F)CC1] |
| 1ϵ-4-24 | 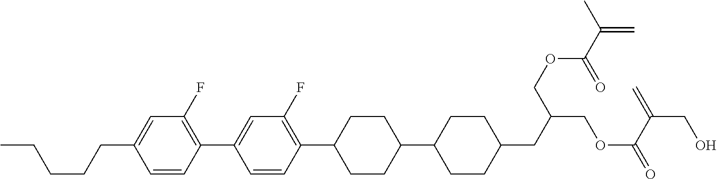 [SMILES: C=C(C)C(=O)OCC(COC(=O)C(=C)CO)CC1CCC(C2CCC(c3ccc(-c4ccc(CCCCC)cc4F)cc3F)CC2)CC1] |
| 1ϵ-4-25 | 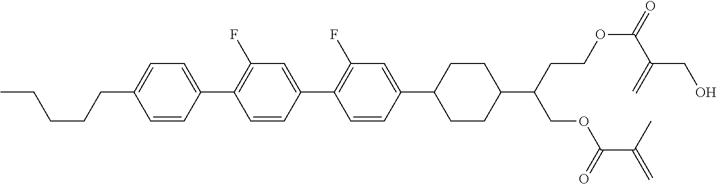 [SMILES: C=C(C)C(=O)OCC(CCOC(=O)C(=C)CO)C1CCC(c2ccc(-c3ccc(-c4ccc(CCCCC)cc4)c(F)c3)c(F)c2)CC1] |
| 1ϵ-4-26 | 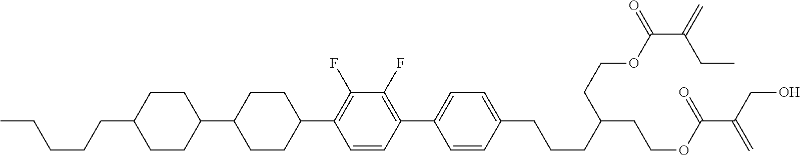 [SMILES: C=C(CC)C(=O)OCCC(CCCc1ccc(-c2ccc(C3CCC(C4CCC(CCCCC)CC4)CC3)c(F)c2F)cc1)CCOC(=O)C(=C)CO] |
| 1ϵ-4-27 | 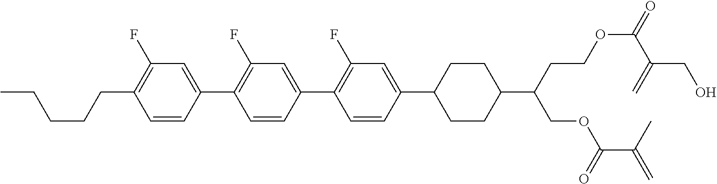 [SMILES: C=C(C)C(=O)OCC(CCOC(=O)C(=C)CO)C1CCC(c2ccc(-c3ccc(-c4ccc(CCCCC)c(F)c4)c(F)c3)c(F)c2)CC1] |
| 1ϵ-4-28 | 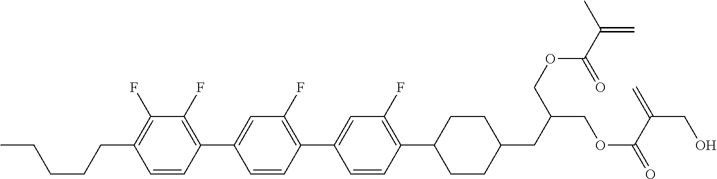 [SMILES: C=C(C)C(=O)OCC(COC(=O)C(=C)CO)CC1CCC(c2ccc(-c3ccc(-c4ccc(CCCCC)c(F)c4F)cc3F)cc2F)CC1] |
| 1ϵ-4-29 | 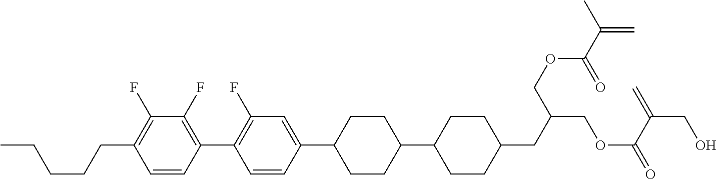 [SMILES: C=C(C)C(=O)OCC(COC(=O)C(=C)CO)CC1CCC(C2CCC(c3ccc(-c4ccc(CCCCC)c(F)c4F)c(F)c3)CC2)CC1] |
| 1ϵ-4-30 | 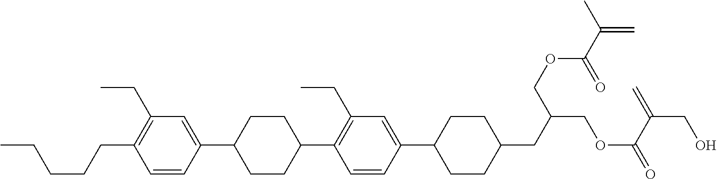 [SMILES: C=C(C)C(=O)OCC(COC(=O)C(=C)CO)CC1CCC(c2ccc(C3CCC(c4ccc(CCCCC)c(CC)c4)CC3)c(CC)c2)CC1] |
| 1ϵ-4-31 | 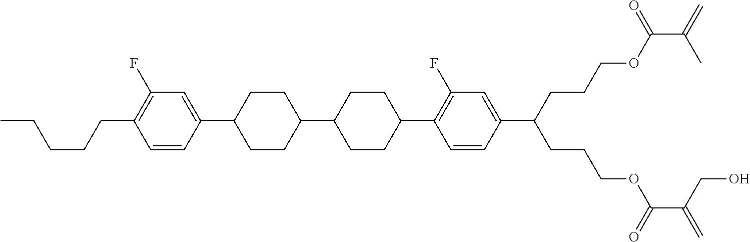 [SMILES: C=C(C)C(=O)OCCCC(CCCOC(=O)C(=C)CO)c1ccc(C2CCC(C3CCC(c4ccc(CCCCC)c(F)c4)CC3)CC2)c(F)c1] |
| 1ϵ-4-32 | 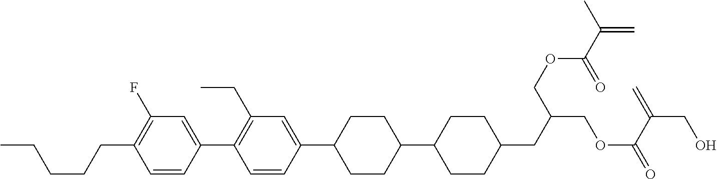 [SMILES: C=C(C)C(=O)OCC(COC(=O)C(=C)CO)CC1CCC(C2CCC(c3ccc(-c4ccc(CCCCC)c(F)c4)c(CC)c3)CC2)CC1] |
| 1ϵ-4-33 | 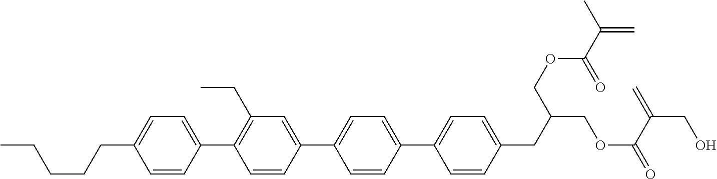 [SMILES: C=C(C)C(=O)OCC(COC(=O)C(=C)CO)Cc1ccc(-c2ccc(-c3ccc(-c4ccc(CCCCC)cc4)c(CC)c3)cc2)cc1] |
| 1ϵ-4-34 | 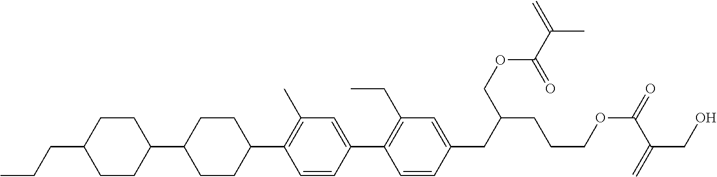 [SMILES: C=C(C)C(=O)OCC(CCCOC(=O)C(=C)CO)Cc1ccc(-c2ccc(C3CCC(C4CCC(CCC)CC4)CC3)c(C)c2)c(CC)c1] |
| 1ϵ-4-35 | 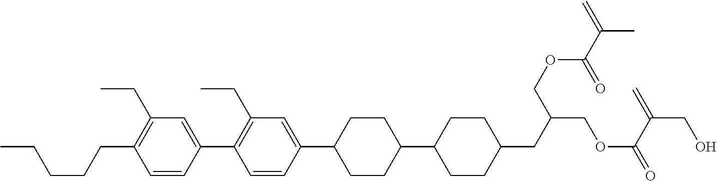 [SMILES: C=C(C)C(=O)OCC(COC(=O)C(=C)CO)CC1CCC(C2CCC(c3ccc(-c4ccc(CCCCC)c(CC)c4)c(CC)c3)CC2)CC1] |
| 1ϵ-4-36 | 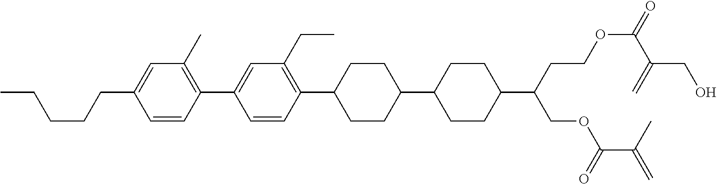 [SMILES: C=C(C)C(=O)OCC(CCOC(=O)C(=C)CO)C1CCC(C2CCC(c3ccc(-c4ccc(CCCCC)cc4C)cc3CC)CC2)CC1] |
| 1ϵ-4-37 | 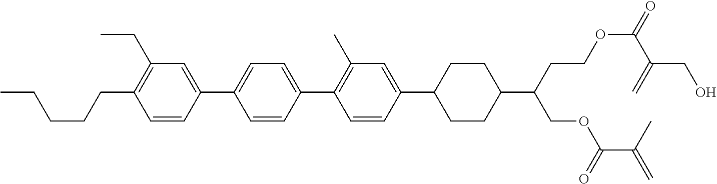 [SMILES: C=C(C)C(=O)OCC(CCOC(=O)C(=C)CO)C1CCC(c2ccc(-c3ccc(-c4ccc(CCCCC)c(CC)c4)cc3)c(C)c2)CC1] |
| 1ϵ-4-38 | 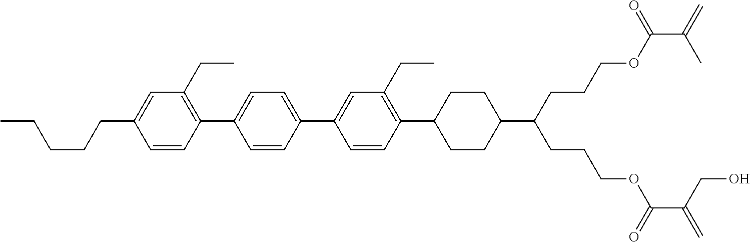 [SMILES: C=C(C)C(=O)OCCCC(CCCOC(=O)C(=C)CO)C1CCC(c2ccc(-c3ccc(-c4ccc(CCCCC)cc4CC)cc3)cc2CC)CC1] |
| 1ϵ-4-39 | 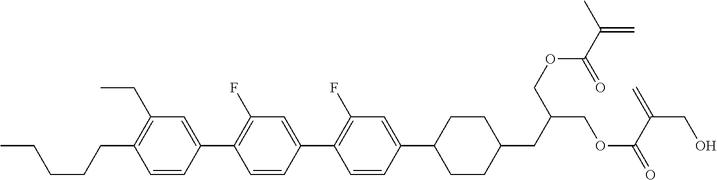 [SMILES: C=C(C)C(=O)OCC(COC(=O)C(=C)CO)CC1CCC(c2ccc(-c3ccc(-c4ccc(CCCCC)c(CC)c4)c(F)c3)c(F)c2)CC1] |
| 1ϵ-4-40 | 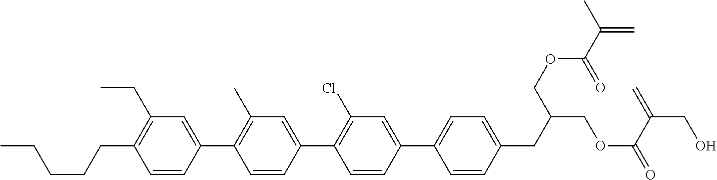 [SMILES: C=C(C)C(=O)OCC(COC(=O)C(=C)CO)Cc1ccc(-c2ccc(-c3ccc(-c4ccc(CCCCC)c(CC)c4)c(C)c3)c(Cl)c2)cc1] |
| 1ϵ-4-41 | 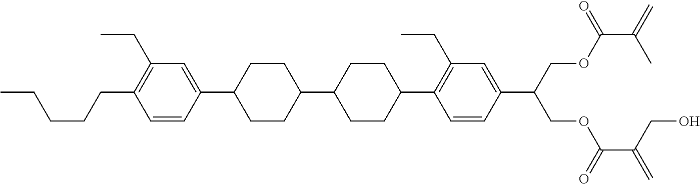 [SMILES: C=C(C)C(=O)OCC(COC(=O)C(=C)CO)c1ccc(C2CCC(C3CCC(c4ccc(CCCCC)c(CC)c4)CC3)CC2)c(CC)c1] |
| 1ϵ-4-42 | 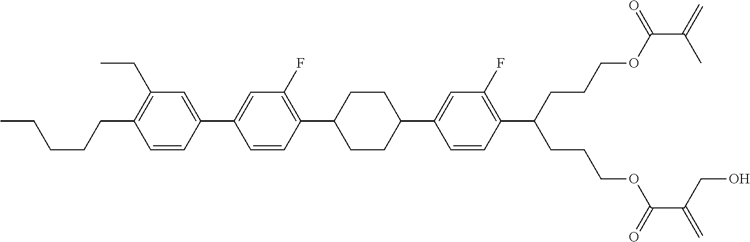 [SMILES: C=C(C)C(=O)OCCCC(CCCOC(=O)C(=C)CO)c1ccc(C2CCC(c3ccc(-c4ccc(CCCCC)c(CC)c4)cc3F)CC2)cc1F] |
| 1ϵ-4-43 | 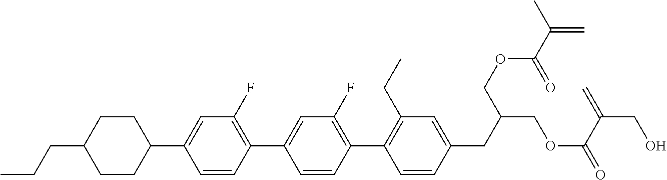 [SMILES: C=C(C)C(=O)OCC(COC(=O)C(=C)CO)Cc1ccc(-c2ccc(-c3ccc(C4CCC(CCC)CC4)cc3F)cc2F)c(CC)c1] |
| 1ϵ-4-44 | 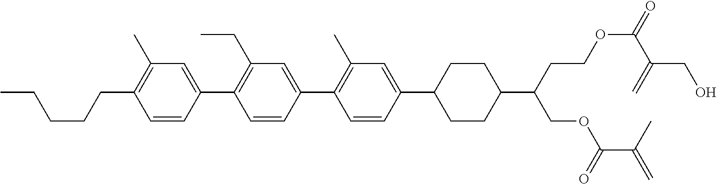 [SMILES: C=C(C)C(=O)OCC(CCOC(=O)C(=C)CO)C1CCC(c2ccc(-c3ccc(-c4ccc(CCCCC)c(C)c4)c(CC)c3)c(C)c2)CC1] |
| 1ϵ-4-45 | 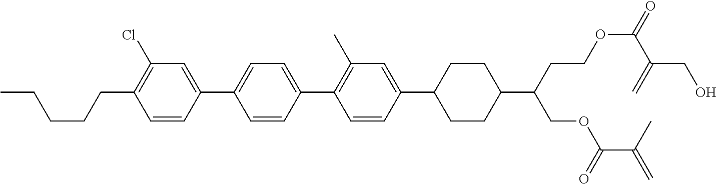 [SMILES: C=C(C)C(=O)OCC(CCOC(=O)C(=C)CO)C1CCC(c2ccc(-c3ccc(-c4ccc(CCCCC)c(Cl)c4)cc3)c(C)c2)CC1] |
| 1ϵ-4-46 | 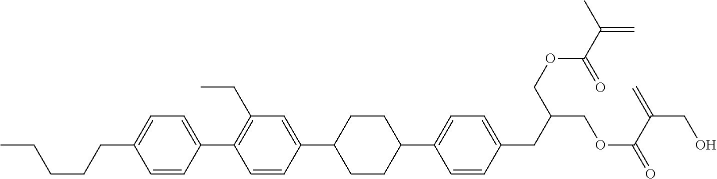 [SMILES: C=C(C)C(=O)OCC(COC(=O)C(=C)CO)Cc1ccc(C2CCC(c3ccc(-c4ccc(CCCCC)cc4)c(CC)c3)CC2)cc1] |
| 1ϵ-4-47 | 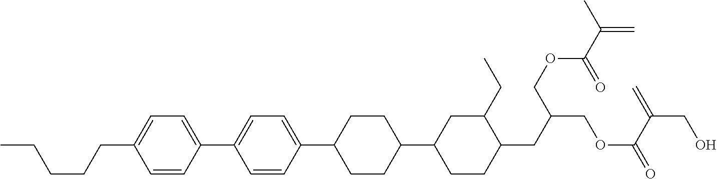 [SMILES: C=C(C)C(=O)OCC(COC(=O)C(=C)CO)CC1CCC(C2CCC(c3ccc(-c4ccc(CCCCC)cc4)cc3)CC2)CC1CC] |
| 1ϵ-4-48 | 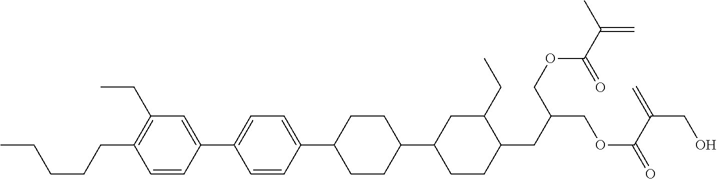 [SMILES: C=C(C)C(=O)OCC(COC(=O)C(=C)CO)CC1CCC(C2CCC(c3ccc(-c4ccc(CCCCC)c(CC)c4)cc3)CC2)CC1CC] |
| 1ϵ-4-49 | 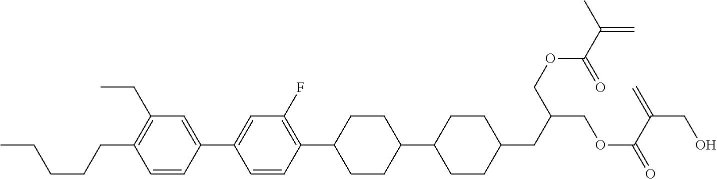 [SMILES: C=C(C)C(=O)OCC(COC(=O)C(=C)CO)CC1CCC(C2CCC(c3ccc(-c4ccc(CCCCC)c(CC)c4)cc3F)CC2)CC1] |
| 1ϵ-4-50 | 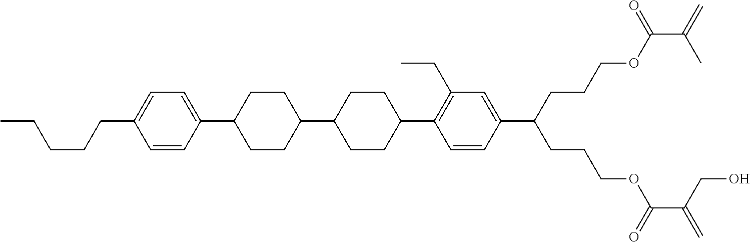 [SMILES: C=C(C)C(=O)OCCCC(CCCOC(=O)C(=C)CO)c1ccc(C2CCC(C3CCC(c4ccc(CCCCC)cc4)CC3)CC2)c(CC)c1] |
| 1ϵ-4-51 | 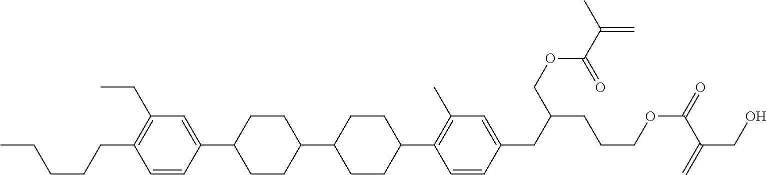 [SMILES: C=C(C)C(=O)OCC(CCCOC(=O)C(=C)CO)Cc1ccc(C2CCC(C3CCC(c4ccc(CCCCC)c(CC)c4)CC3)CC2)c(C)c1] |
| 1ϵ-4-52 | 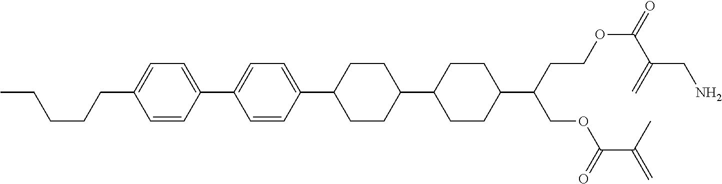 [SMILES: C=C(C)C(=O)OCC(CCOC(=O)C(=C)CN)C1CCC(C2CCC(c3ccc(-c4ccc(CCCCC)cc4)cc3)CC2)CC1] |
| 1ϵ-4-53 | 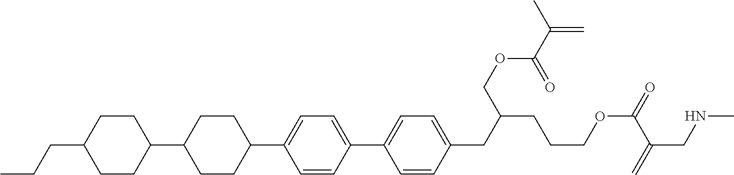 [SMILES: C=C(C)C(=O)OCC(CCCOC(=O)C(=C)CNC)Cc1ccc(-c2ccc(C3CCC(C4CCC(CCC)CC4)CC3)cc2)cc1] |
| 1ϵ-4-54 | 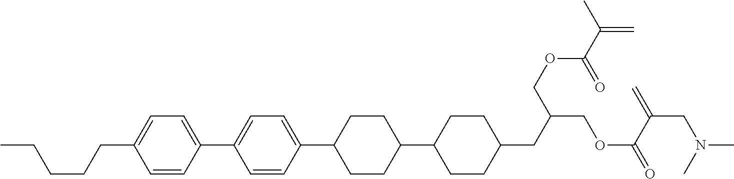 [SMILES: C=C(C)C(=O)OCC(COC(=O)C(=C)CN(C)C)CC1CCC(C2CCC(c3ccc(-c4ccc(CCCCC)cc4)cc3)CC2)CC1] |
| 1ϵ-4-55 | 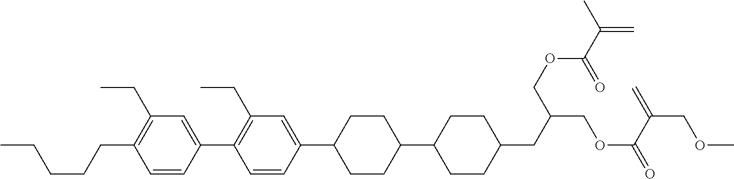 [SMILES: C=C(C)C(=O)OCC(COC(=O)C(=C)COC)CC1CCC(C2CCC(c3ccc(-c4ccc(CCCCC)c(CC)c4)c(CC)c3)CC2)CC1] |
| 1ϵ-4-56 | 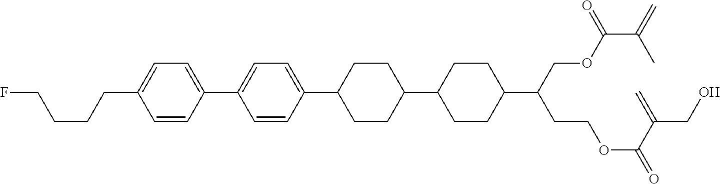 [SMILES: C=C(C)C(=O)OCC(CCOC(=O)C(=C)CO)C1CCC(C2CCC(c3ccc(-c4ccc(CCCCF)cc4)cc3)CC2)CC1] |
| 1ϵ-4-57 | 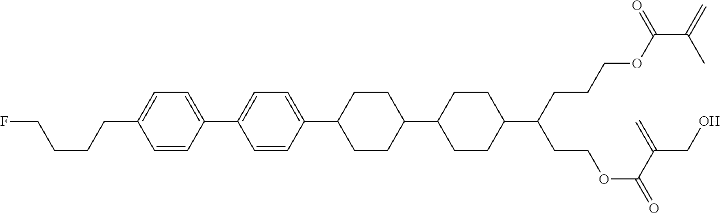 [SMILES: C=C(C)C(=O)OCCCC(CCOC(=O)C(=C)CO)C1CCC(C2CCC(c3ccc(-c4ccc(CCCCF)cc4)cc3)CC2)CC1] |
| 1ϵ-4-58 | 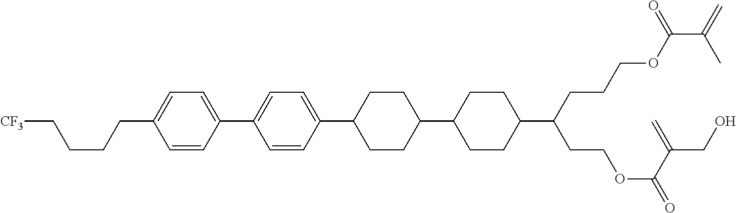 [SMILES: C=C(C)C(=O)OCCCC(CCOC(=O)C(=C)CO)C1CCC(C2CCC(c3ccc(-c4ccc(CCCCC(F)(F)F)cc4)cc3)CC2)CC1] |
| 1ϵ-4-59 | 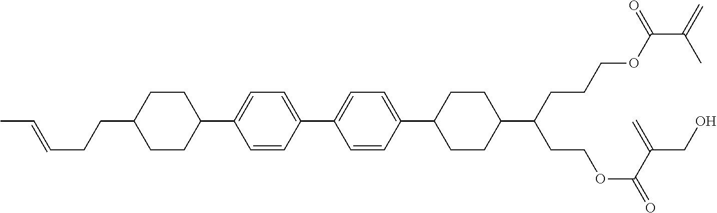 [SMILES: C=C(C)C(=O)OCCCC(CCOC(=O)C(=C)CO)C1CCC(c2ccc(-c3ccc(C4CCC(CC/C=C/C)CC4)cc3)cc2)CC1] |
| 1ϵ-4-60 | 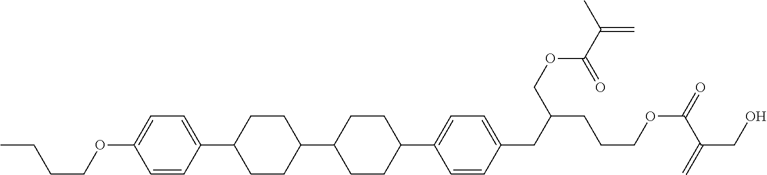 [SMILES: C=C(C)C(=O)OCC(CCCOC(=O)C(=C)CO)Cc1ccc(C2CCC(C3CCC(c4ccc(OCCCC)cc4)CC3)CC2)cc1] |
| 1ϵ-4-61 | 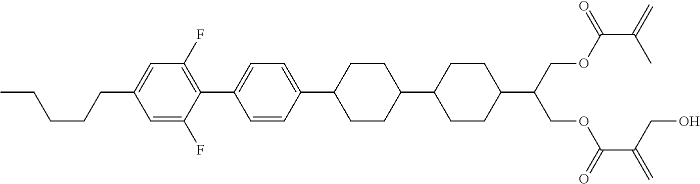 [SMILES: C=C(C)C(=O)OCC(COC(=O)C(=C)CO)C1CCC(C2CCC(c3ccc(-c4c(F)cc(CCCCC)cc4F)cc3)CC2)CC1] |
| 1ϵ-4-62 | 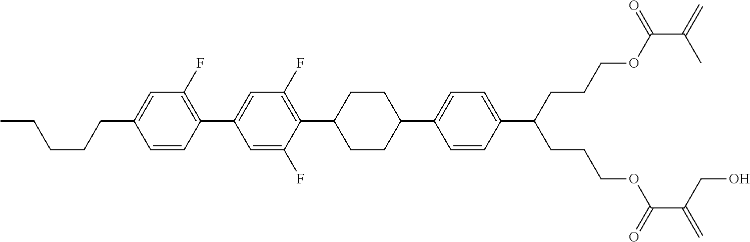 [SMILES: C=C(C)C(=O)OCCCC(CCCOC(=O)C(=C)CO)c1ccc(C2CCC(c3c(F)cc(-c4ccc(CCCCC)cc4F)cc3F)CC2)cc1] |
| 1ϵ-4-63 | 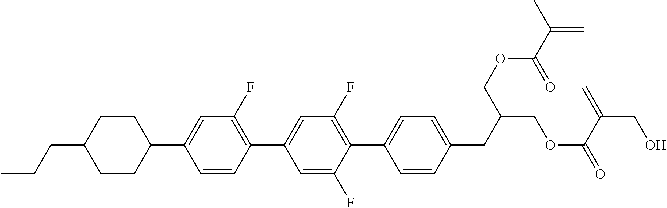 [SMILES: C=C(C)C(=O)OCC(COC(=O)C(=C)CO)Cc1ccc(-c2c(F)cc(-c3ccc(C4CCC(CCC)CC4)cc3F)cc2F)cc1] |
| 1ϵ-4-64 | 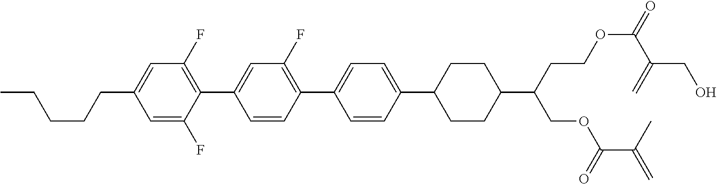 [SMILES: C=C(C)C(=O)OCC(CCOC(=O)C(=C)CO)C1CCC(c2ccc(-c3ccc(-c4c(F)cc(CCCCC)cc4F)cc3F)cc2)CC1] |
| 1ϵ-4-65 | 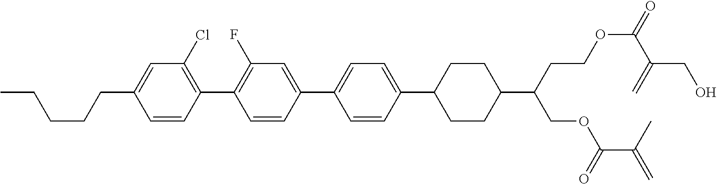 [SMILES: C=C(C)C(=O)OCC(CCOC(=O)C(=C)CO)C1CCC(c2ccc(-c3ccc(-c4ccc(CCCCC)cc4Cl)c(F)c3)cc2)CC1] |
| 1ϵ-4-66 | 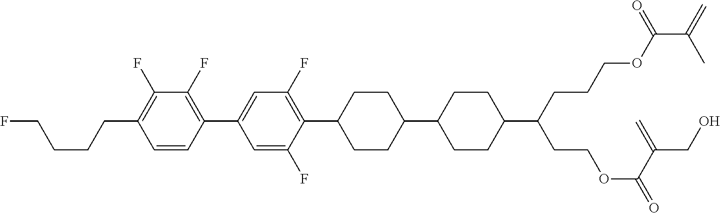 [SMILES: C=C(C)C(=O)OCCCC(CCOC(=O)C(=C)CO)C1CCC(C2CCC(c3c(F)cc(-c4ccc(CCCCF)c(F)c4F)cc3F)CC2)CC1] |
| 1ϵ-4-67 | 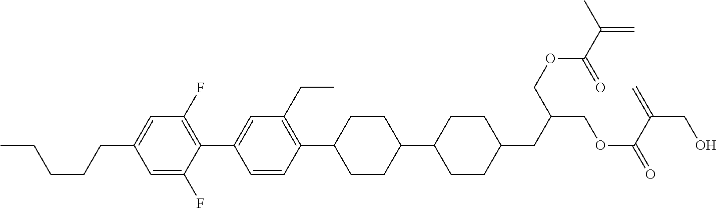 [SMILES: C=C(C)C(=O)OCC(COC(=O)C(=C)CO)CC1CCC(C2CCC(c3ccc(-c4c(F)cc(CCCCC)cc4F)cc3CC)CC2)CC1] |
| 1ϵ-4-68 | 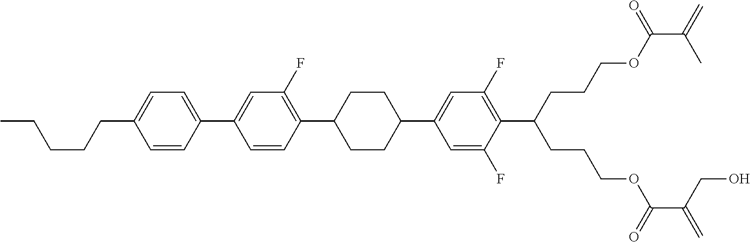 [SMILES: C=C(C)C(=O)OCCCC(CCCOC(=O)C(=C)CO)c1c(F)cc(C2CCC(c3ccc(-c4ccc(CCCCC)cc4)cc3F)CC2)cc1F] |
| 1ϵ-4-69 | 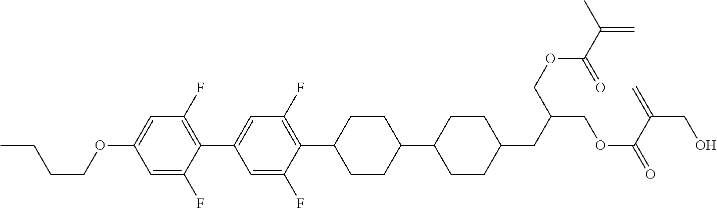 [SMILES: C=C(C)C(=O)OCC(COC(=O)C(=C)CO)CC1CCC(C2CCC(c3c(F)cc(-c4c(F)cc(OCCCC)cc4F)cc3F)CC2)CC1] |
| 1ϵ-4-70 | 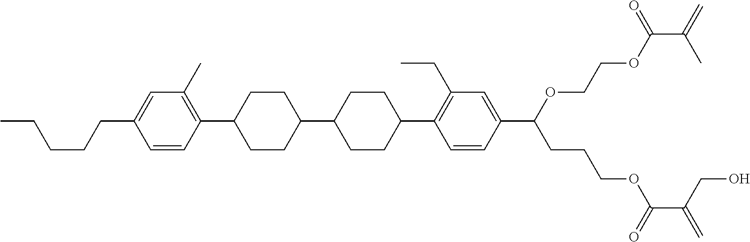 [SMILES: C=C(C)C(=O)OCCOC(CCCOC(=O)C(=C)CO)c1ccc(C2CCC(C3CCC(c4ccc(CCCCC)cc4C)CC3)CC2)c(CC)c1] |
| 1ϵ-4-71 | 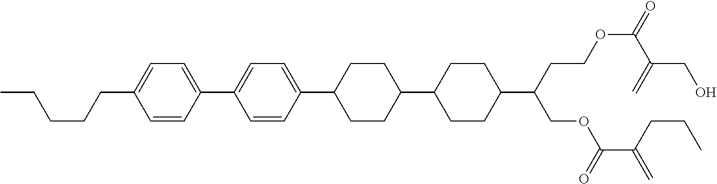 [SMILES: C=C(CO)C(=O)OCCC(COC(=O)C(=C)CCC)C1CCC(C2CCC(c3ccc(-c4ccc(CCCCC)cc4)cc3)CC2)CC1] |
| 1ϵ-4-72 | 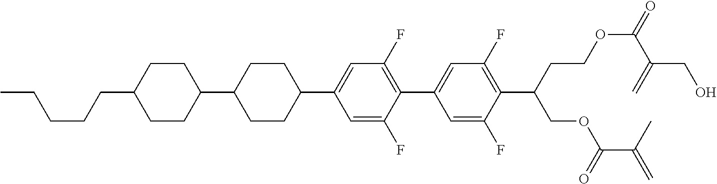 [SMILES: C=C(C)C(=O)OCC(CCOC(=O)C(=C)CO)c1c(F)cc(-c2c(F)cc(C3CCC(C4CCC(CCCCC)CC4)CC3)cc2F)cc1F] |
| 1ϵ-4-73 | 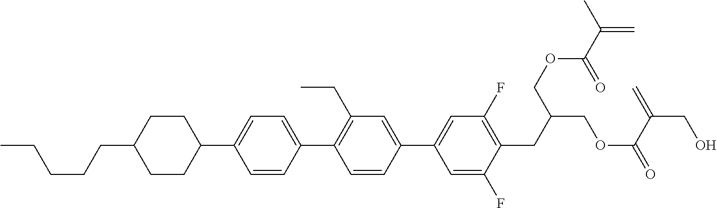 [SMILES: C=C(C)C(=O)OCC(COC(=O)C(=C)CO)Cc1c(F)cc(-c2ccc(-c3ccc(C4CCC(CCCCC)CC4)cc3)c(CC)c2)cc1F] |
| 1ϵ-4-74 | 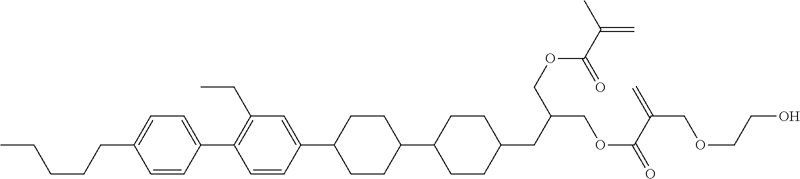 [SMILES: C=C(C)C(=O)OCC(COC(=O)C(=C)COCCO)CC1CCC(C2CCC(c3ccc(-c4ccc(CCCCC)cc4)c(CC)c3)CC2)CC1] |
| 1ϵ-4-75 | 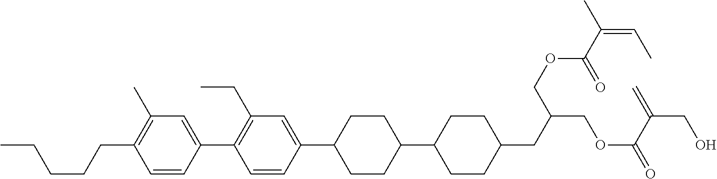 [SMILES: C=C(CO)C(=O)OCC(COC(=O)/C(C)=C\C)CC1CCC(C2CCC(c3ccc(-c4ccc(CCCCC)c(C)c4)c(CC)c3)CC2)CC1] |
| 1ϵ-4-76 | 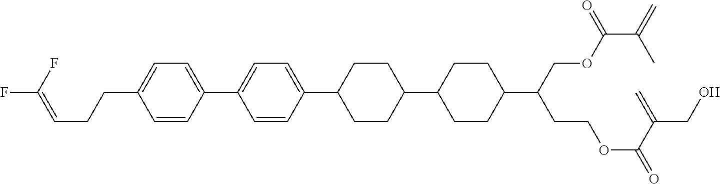 [SMILES: C=C(C)C(=O)OCC(CCOC(=O)C(=C)CO)C1CCC(C2CCC(c3ccc(-c4ccc(CCC=C(F)F)cc4)cc3)CC2)CC1] |
| 1ϵ-4-77 | 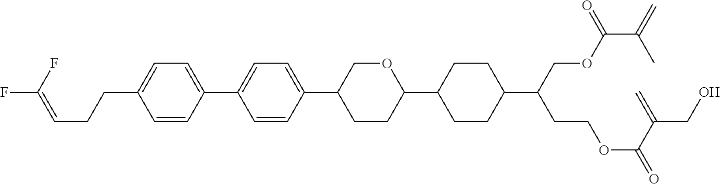 [SMILES: C=C(C)C(=O)OCC(CCOC(=O)C(=C)CO)C1CCC(C2CCC(c3ccc(-c4ccc(CCC=C(F)F)cc4)cc3)CO2)CC1] |
| 1ϵ-4-78 | 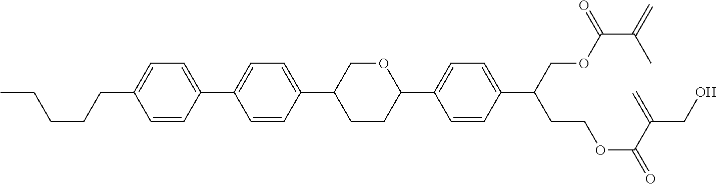 [SMILES: C=C(C)C(=O)OCC(CCOC(=O)C(=C)CO)c1ccc(C2CCC(c3ccc(-c4ccc(CCCCC)cc4)cc3)CO2)cc1] |
| 1ϵ-4-79 | 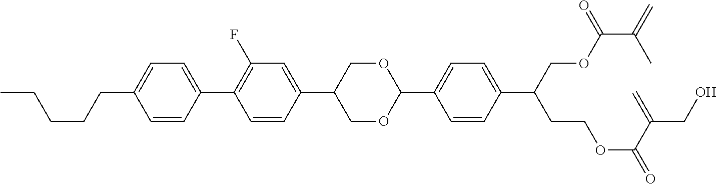 [SMILES: C=C(C)C(=O)OCC(CCOC(=O)C(=C)CO)c1ccc(C2OCC(c3ccc(-c4ccc(CCCCC)cc4)c(F)c3)CO2)cc1] |
| 1ϵ-4-80 | 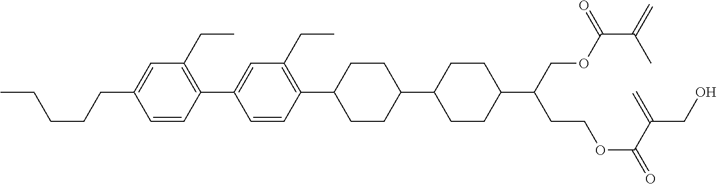 [SMILES: C=C(C)C(=O)OCC(CCOC(=O)C(=C)CO)C1CCC(C2CCC(c3ccc(-c4ccc(CCCCC)cc4CC)cc3CC)CC2)CC1] |
| 1ϵ-4-81 | 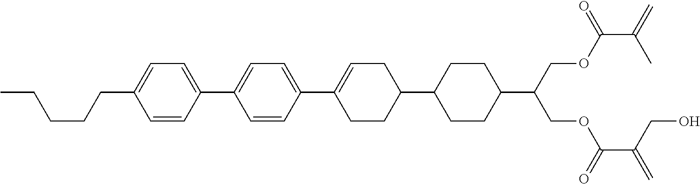 [SMILES: C=C(C)C(=O)OCC(COC(=O)C(=C)CO)C1CCC(C2CC=C(c3ccc(-c4ccc(CCCCC)cc4)cc3)CC2)CC1] |
| 1ϵ-4-82 | 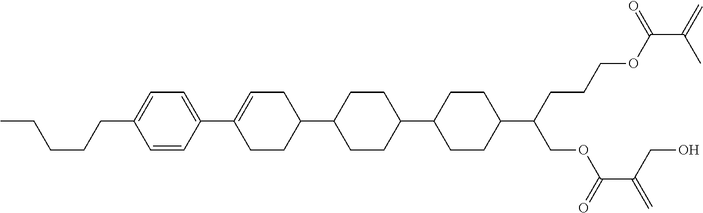 [SMILES: C=C(C)C(=O)OCCCC(COC(=O)C(=C)CO)C1CCC(C2CCC(C3CC=C(c4ccc(CCCCC)cc4)CC3)CC2)CC1] |
| 1ϵ-4-83 | 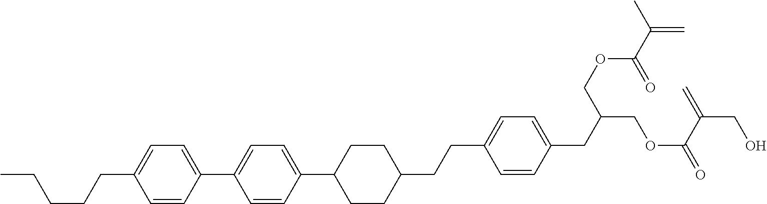 [SMILES: C=C(C)C(=O)OCC(COC(=O)C(=C)CO)Cc1ccc(CCC2CCC(c3ccc(-c4ccc(CCCCC)cc4)cc3)CC2)cc1] |
| 1ϵ-4-84 | 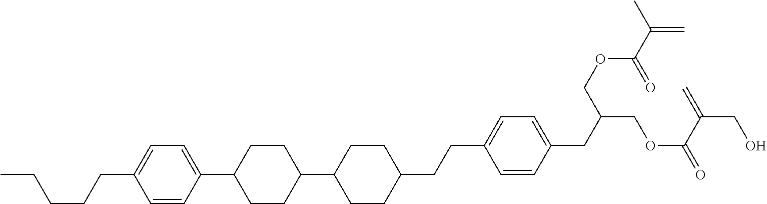 [SMILES: C=C(C)C(=O)OCC(COC(=O)C(=C)CO)Cc1ccc(CCC2CCC(C3CCC(c4ccc(CCCCC)cc4)CC3)CC2)cc1] |
| 1ϵ-4-85 | 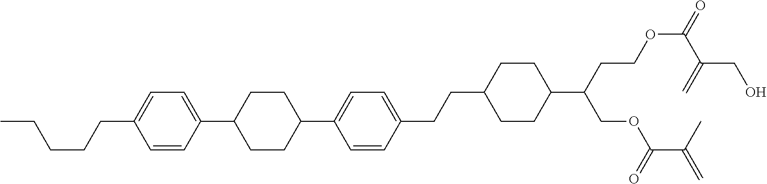 [SMILES: C=C(C)C(=O)OCC(CCOC(=O)C(=C)CO)C1CCC(CCc2ccc(C3CCC(c4ccc(CCCCC)cc4)CC3)cc2)CC1] |
| 1ϵ-4-86 | 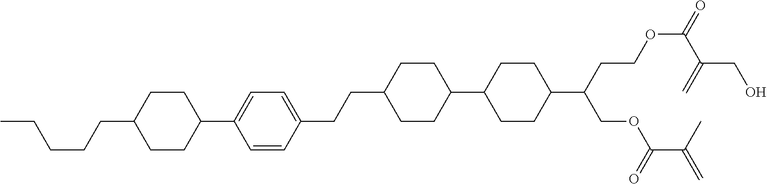 [SMILES: C=C(C)C(=O)OCC(CCOC(=O)C(=C)CO)C1CCC(C2CCC(CCc3ccc(C4CCC(CCCCC)CC4)cc3)CC2)CC1] |
| 1ϵ-4-87 | 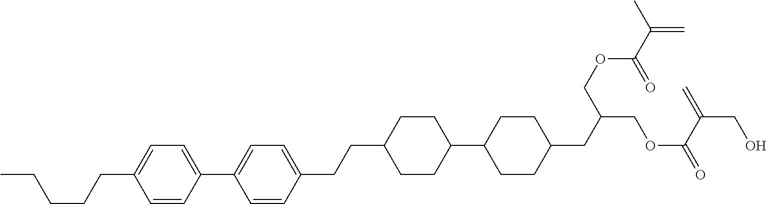 [SMILES: C=C(C)C(=O)OCC(COC(=O)C(=C)CO)CC1CCC(C2CCC(CCc3ccc(-c4ccc(CCCCC)cc4)cc3)CC2)CC1] |
| 1ϵ-4-88 | 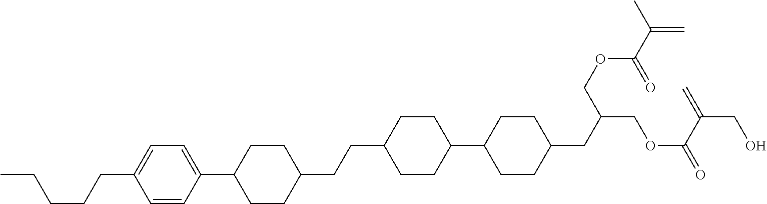 [SMILES: C=C(C)C(=O)OCC(COC(=O)C(=C)CO)CC1CCC(C2CCC(CCC3CCC(c4ccc(CCCCC)cc4)CC3)CC2)CC1] |
| 1ϵ-4-89 | 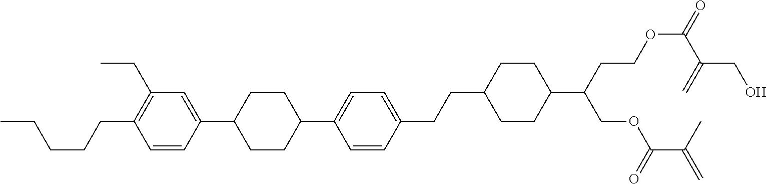 [SMILES: C=C(C)C(=O)OCC(CCOC(=O)C(=C)CO)C1CCC(CCc2ccc(C3CCC(c4ccc(CCCCC)c(CC)c4)CC3)cc2)CC1] |
| 1ϵ-4-90 | 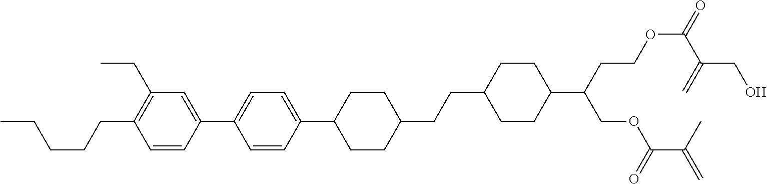 [SMILES: C=C(C)C(=O)OCC(CCOC(=O)C(=C)CO)C1CCC(CCC2CCC(c3ccc(-c4ccc(CCCCC)c(CC)c4)cc3)CC2)CC1] |
| 1ϵ-4-91 | 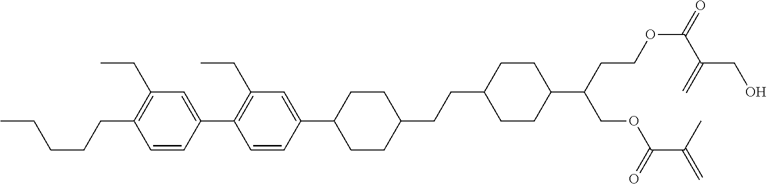 [SMILES: C=C(C)C(=O)OCC(CCOC(=O)C(=C)CO)C1CCC(CCC2CCC(c3ccc(-c4ccc(CCCCC)c(CC)c4)c(CC)c3)CC2)CC1] |
| 1ϵ-4-92 | 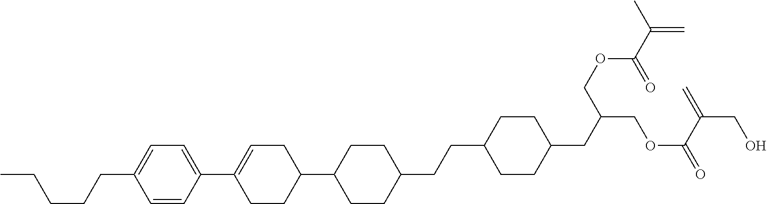 [SMILES: C=C(C)C(=O)OCC(COC(=O)C(=C)CO)CC1CCC(CCC2CCC(C3CC=C(c4ccc(CCCCC)cc4)CC3)CC2)CC1] |
| 1ϵ-4-93 | 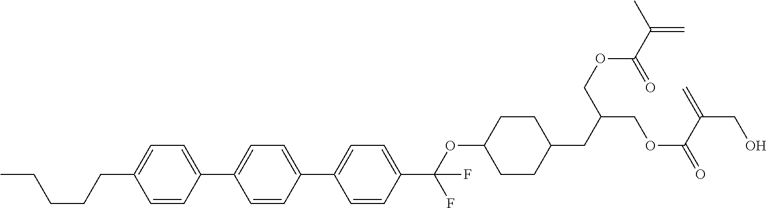 [SMILES: C=C(C)C(=O)OCC(COC(=O)C(=C)CO)CC1CCC(OC(F)(F)c2ccc(-c3ccc(-c4ccc(CCCCC)cc4)cc3)cc2)CC1] |
| 1ϵ-4-94 | 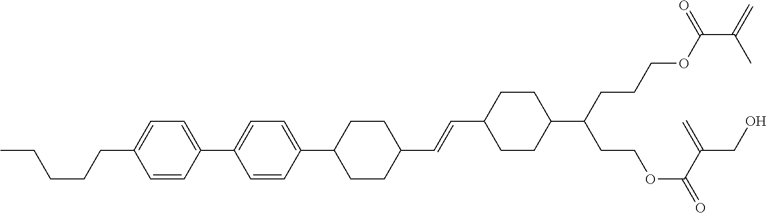 [SMILES: C=C(C)C(=O)OCCCC(CCOC(=O)C(=C)CO)C1CCC(/C=C/C2CCC(c3ccc(-c4ccc(CCCCC)cc4)cc3)CC2)CC1] |
| 1ϵ-4-95 | 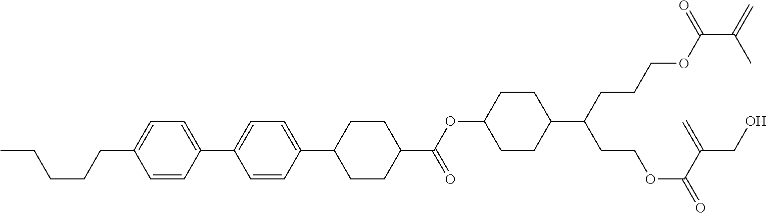 [SMILES: C=C(C)C(=O)OCCCC(CCOC(=O)C(=C)CO)C1CCC(OC(=O)C2CCC(c3ccc(-c4ccc(CCCCC)cc4)cc3)CC2)CC1] |
| 1ϵ-4-96 | 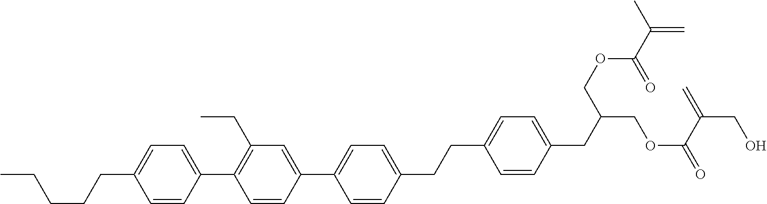 [SMILES: C=C(C)C(=O)OCC(COC(=O)C(=C)CO)Cc1ccc(CCc2ccc(-c3ccc(-c4ccc(CCCCC)cc4)c(CC)c3)cc2)cc1] |
| 1ϵ-4-97 | 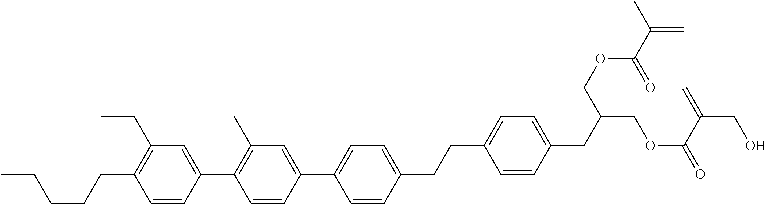 [SMILES: C=C(C)C(=O)OCC(COC(=O)C(=C)CO)Cc1ccc(CCc2ccc(-c3ccc(-c4ccc(CCCCC)c(CC)c4)c(C)c3)cc2)cc1] |
| 1ϵ-4-98 | 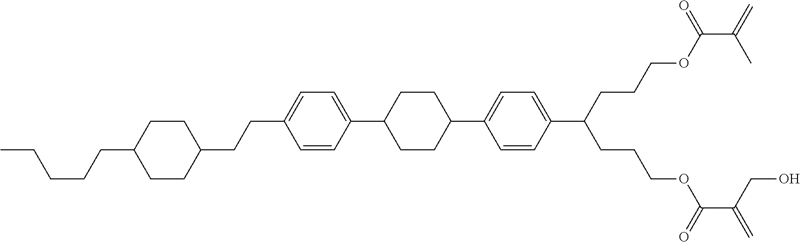 [SMILES: C=C(C)C(=O)OCCCC(CCCOC(=O)C(=C)CO)c1ccc(C2CCC(c3ccc(CCC4CCC(CCCCC)CC4)cc3)CC2)cc1] |
| 1ϵ-4-99 | 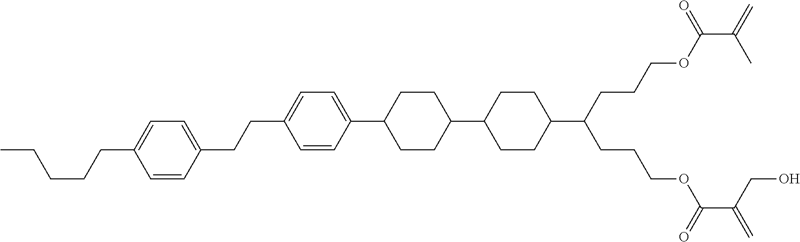 [SMILES: C=C(C)C(=O)OCCCC(CCCOC(=O)C(=C)CO)C1CCC(C2CCC(c3ccc(CCc4ccc(CCCCC)cc4)cc3)CC2)CC1] |
| 1ϵ-4-100 | 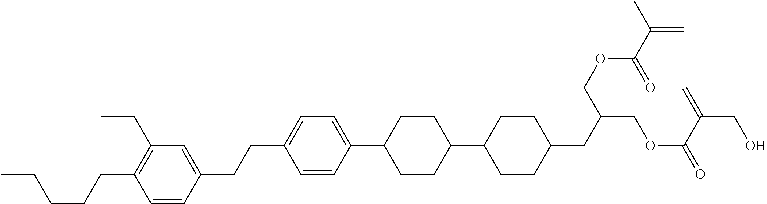 [SMILES: C=C(C)C(=O)OCC(COC(=O)C(=C)CO)CC1CCC(C2CCC(c3ccc(CCc4ccc(CCCCC)c(CC)c4)cc3)CC2)CC1] |
| 1ϵ-4-101 | 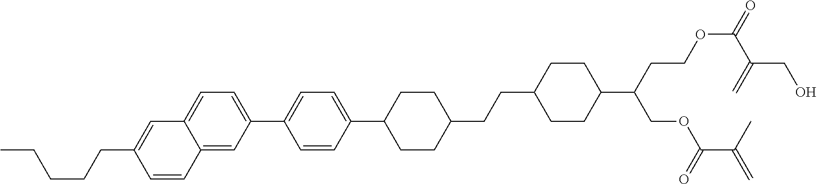 [SMILES: C=C(C)C(=O)OCC(CCOC(=O)C(=C)CO)C1CCC(CCC2CCC(c3ccc(-c4ccc5cc(CCCCC)ccc5c4)cc3)CC2)CC1] |
| 1ϵ-4-102 | 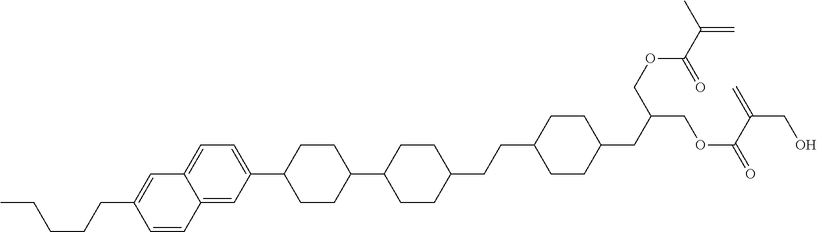 [SMILES: C=C(C)C(=O)OCC(COC(=O)C(=C)CO)CC1CCC(CCC2CCC(C3CCC(c4ccc5cc(CCCCC)ccc5c4)CC3)CC2)CC1] |
| 1ϵ-4-103 | 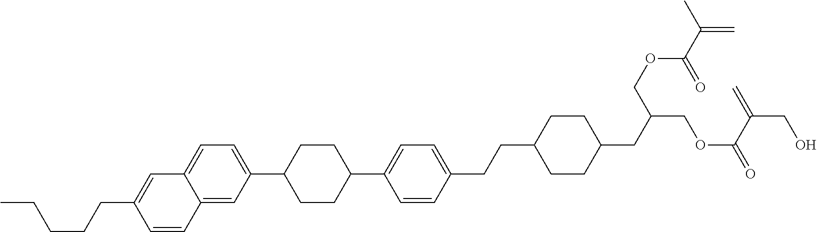 [SMILES: C=C(C)C(=O)OCC(COC(=O)C(=C)CO)CC1CCC(CCc2ccc(C3CCC(c4ccc5cc(CCCCC)ccc5c4)CC3)cc2)CC1] |
| 1ϵ-4-104 | 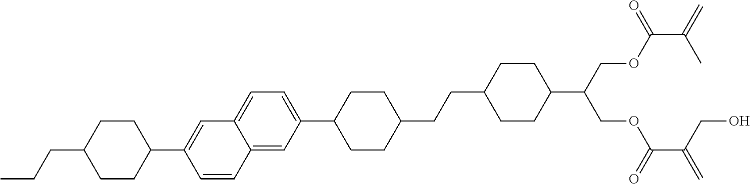 [SMILES: C=C(C)C(=O)OCC(COC(=O)C(=C)CO)C1CCC(CCC2CCC(c3ccc4cc(C5CCC(CCC)CC5)ccc4c3)CC2)CC1] |
| 1ϵ-4-105 | 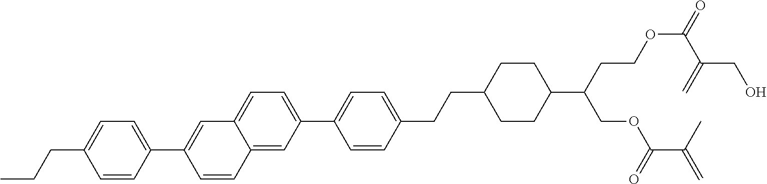 [SMILES: C=C(C)C(=O)OCC(CCOC(=O)C(=C)CO)C1CCC(CCc2ccc(-c3ccc4cc(-c5ccc(CCC)cc5)ccc4c3)cc2)CC1] |
| 1ϵ-4-106 | 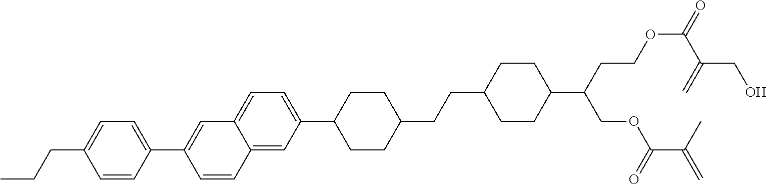 [SMILES: C=C(C)C(=O)OCC(CCOC(=O)C(=C)CO)C1CCC(CCC2CCC(c3ccc4cc(-c5ccc(CCC)cc5)ccc4c3)CC2)CC1] |
| 1ϵ-4-107 | 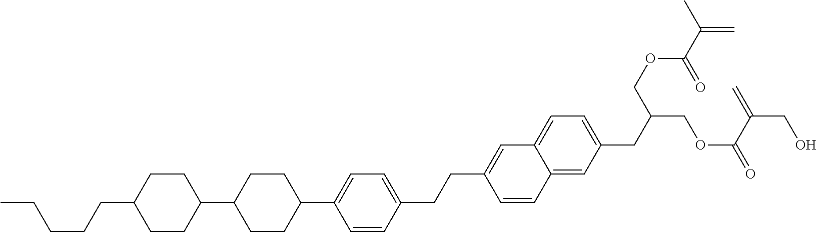 [SMILES: C=C(C)C(=O)OCC(COC(=O)C(=C)CO)Cc1ccc2cc(CCc3ccc(C4CCC(C5CCC(CCCCC)CC5)CC4)cc3)ccc2c1] |
| 1ϵ-4-108 | 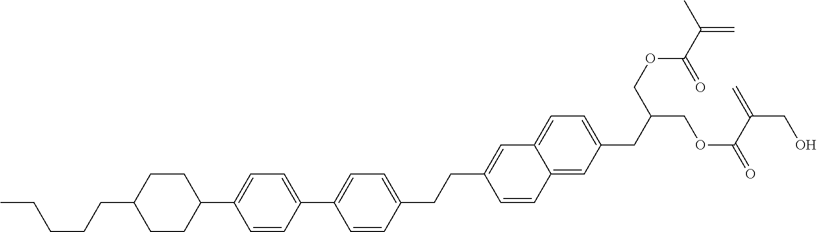 [SMILES: C=C(C)C(=O)OCC(COC(=O)C(=C)CO)Cc1ccc2cc(CCc3ccc(-c4ccc(C5CCC(CCCCC)CC5)cc4)cc3)ccc2c1] |
| 1ϵ-4-109 | 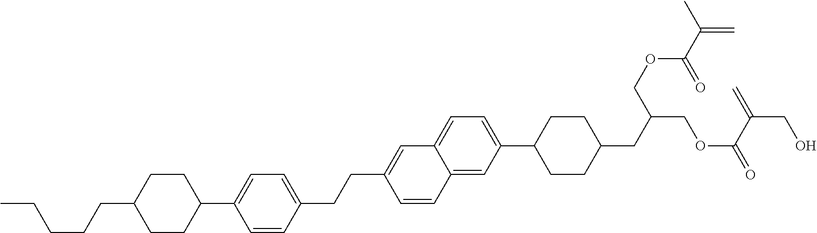 [SMILES: C=C(C)C(=O)OCC(COC(=O)C(=C)CO)CC1CCC(c2ccc3cc(CCc4ccc(C5CCC(CCCCC)CC5)cc4)ccc3c2)CC1] |
| 1ϵ-4-110 | 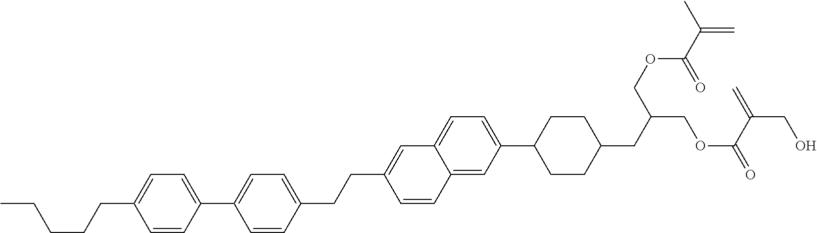 [SMILES: C=C(C)C(=O)OCC(COC(=O)C(=C)CO)CC1CCC(c2ccc3cc(CCc4ccc(-c5ccc(CCCCC)cc5)cc4)ccc3c2)CC1] |
| 1ϵ-4-111 | 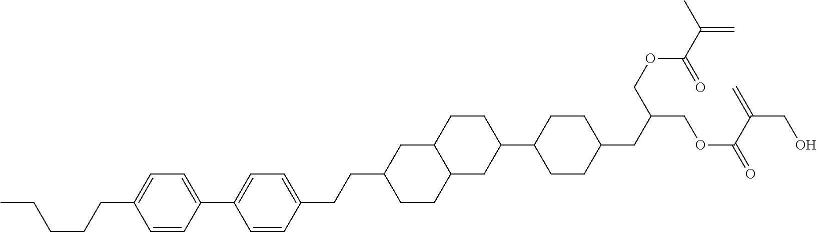 [SMILES: C=C(C)C(=O)OCC(COC(=O)C(=C)CO)CC1CCC(C2CCC3CC(CCc4ccc(-c5ccc(CCCCC)cc5)cc4)CCC3C2)CC1] |
| 1ϵ-4-112 | 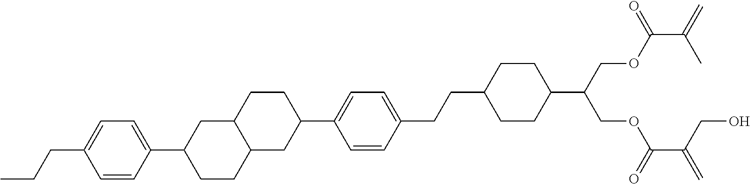 [SMILES: C=C(C)C(=O)OCC(COC(=O)C(=C)CO)C1CCC(CCc2ccc(C3CCC4CC(c5ccc(CCC)cc5)CCC4C3)cc2)CC1] |
| 1ϵ-4-113 | 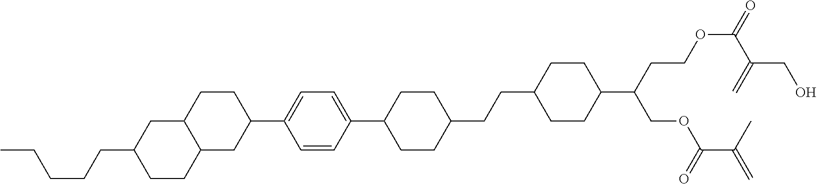 [SMILES: C=C(C)C(=O)OCC(CCOC(=O)C(=C)CO)C1CCC(CCC2CCC(c3ccc(C4CCC5CC(CCCCC)CCC5C4)cc3)CC2)CC1] |
| 1ϵ-4-114 | 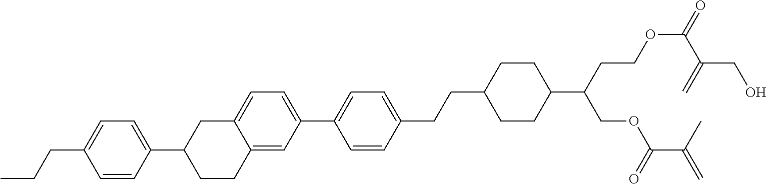 [SMILES: C=C(C)C(=O)OCC(CCOC(=O)C(=C)CO)C1CCC(CCc2ccc(-c3ccc4c(c3)CCC(c3ccc(CCC)cc3)C4)cc2)CC1] |
| 1ϵ-4-115 | 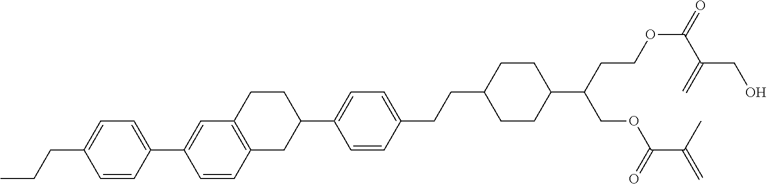 [SMILES: C=C(C)C(=O)OCC(CCOC(=O)C(=C)CO)C1CCC(CCc2ccc(C3CCc4cc(-c5ccc(CCC)cc5)ccc4C3)cc2)CC1] |
| 1ϵ-4-116 | 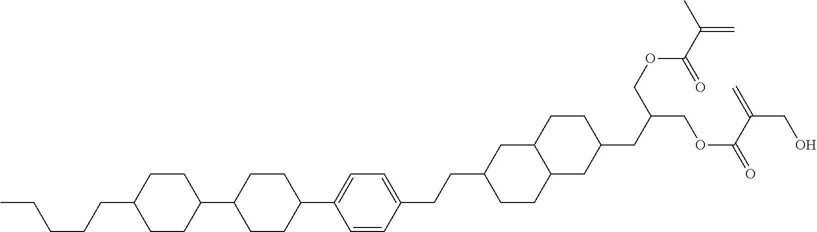 [SMILES: C=C(C)C(=O)OCC(COC(=O)C(=C)CO)CC1CCC2CC(CCc3ccc(C4CCC(C5CCC(CCCCC)CC5)CC4)cc3)CCC2C1] |
| 1ϵ-4-117 | 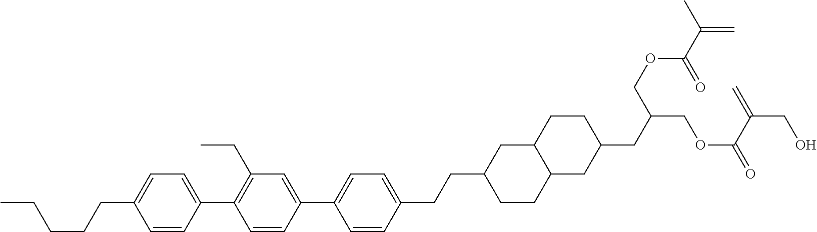 [SMILES: C=C(C)C(=O)OCC(COC(=O)C(=C)CO)CC1CCC2CC(CCc3ccc(-c4ccc(-c5ccc(CCCCC)cc5)c(CC)c4)cc3)CCC2C1] |
| 1ϵ-4-118 | 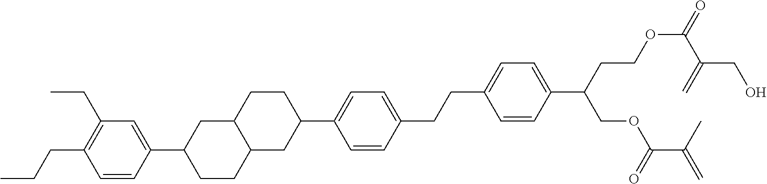 [SMILES: C=C(C)C(=O)OCC(CCOC(=O)C(=C)CO)c1ccc(CCc2ccc(C3CCC4CC(c5ccc(CCC)c(CC)c5)CCC4C3)cc2)cc1] |
| 1ϵ-4-119 | 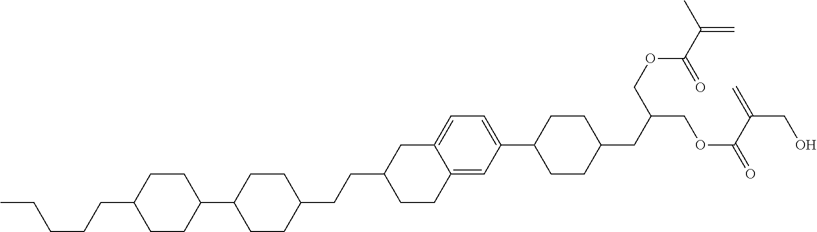 [SMILES: C=C(C)C(=O)OCC(COC(=O)C(=C)CO)CC1CCC(c2ccc3c(c2)CCC(CCC2CCC(C4CCC(CCCCC)CC4)CC2)C3)CC1] |
| 1ϵ-4-120 | 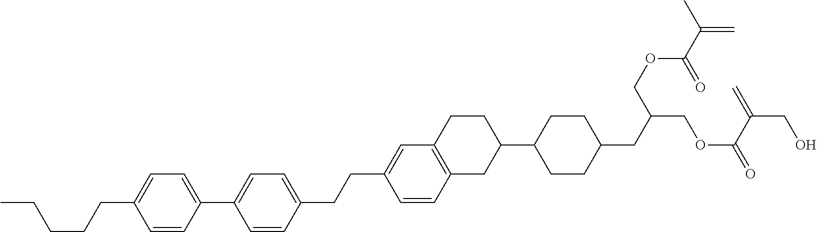 [SMILES: C=C(C)C(=O)OCC(COC(=O)C(=C)CO)CC1CCC(C2CCc3cc(CCc4ccc(-c5ccc(CCCCC)cc5)cc4)ccc3C2)CC1] |
| 1ϵ-4-121 | 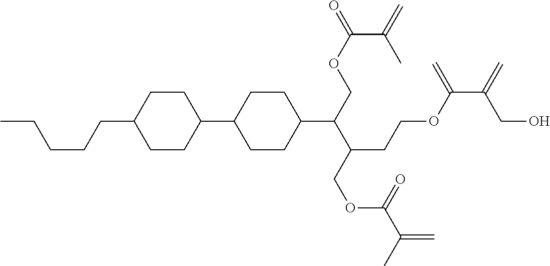 [SMILES: C=C(C)C(=O)OCC(CCOC(=C)C(=C)CO)C(COC(=O)C(=C)C)C1CCC(C2CCC(CCCCC)CC2)CC1] |
| 1ϵ-4-122 | 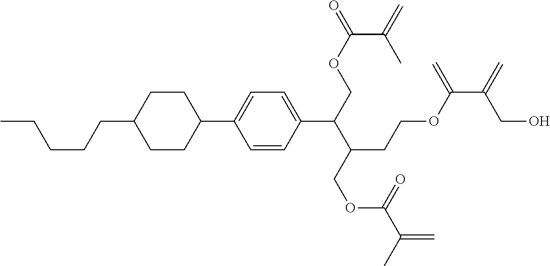 [SMILES: C=C(C)C(=O)OCC(CCOC(=C)C(=C)CO)C(COC(=O)C(=C)C)c1ccc(C2CCC(CCCCC)CC2)cc1] |
| 1ϵ-4-123 | 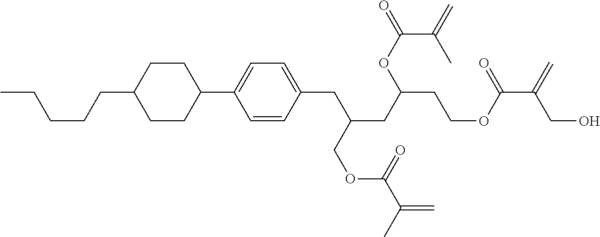 [SMILES: C=C(C)C(=O)OCC(Cc1ccc(C2CCC(CCCCC)CC2)cc1)CC(CCOC(=O)C(=C)CO)OC(=O)C(=C)C] |
| 1ϵ-4-124 | 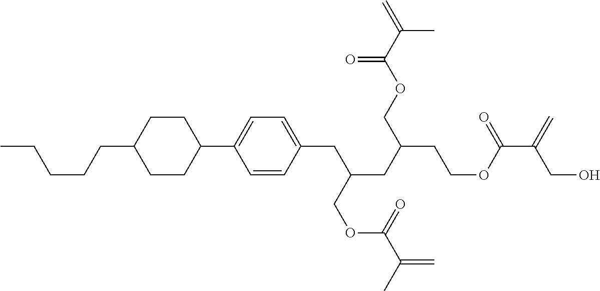 [SMILES: C=C(C)C(=O)OCC(CCOC(=O)C(=C)CO)CC(COC(=O)C(=C)C)Cc1ccc(C2CCC(CCCCC)CC2)cc1] |
| 1ϵ-4-125 | 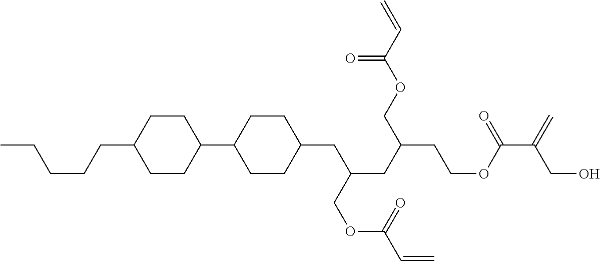 [SMILES: C=CC(=O)OCC(CCOC(=O)C(=C)CO)CC(COC(=O)C=C)CC1CCC(C2CCC(CCCCC)CC2)CC1] |
| 1ϵ-4-126 | 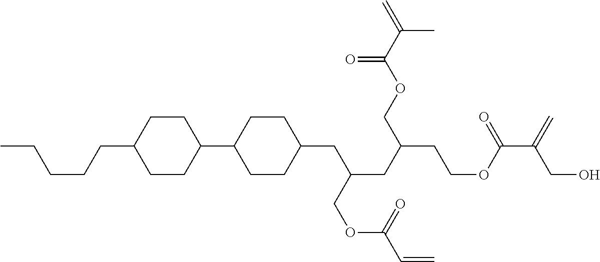 [SMILES: C=CC(=O)OCC(CC1CCC(C2CCC(CCCCC)CC2)CC1)CC(CCOC(=O)C(=C)CO)COC(=O)C(=C)C] |
| 1ϵ-4-127 | 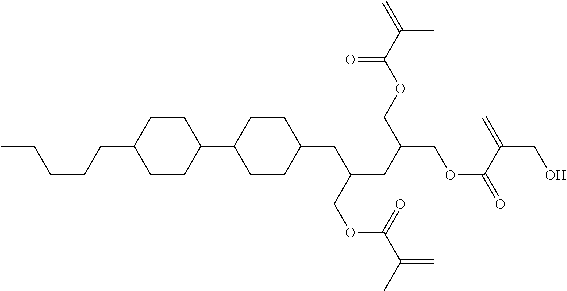 [SMILES: C=C(C)C(=O)OCC(COC(=O)C(=C)CO)CC(COC(=O)C(=C)C)CC1CCC(C2CCC(CCCCC)CC2)CC1] |
| 1ϵ-4-128 | 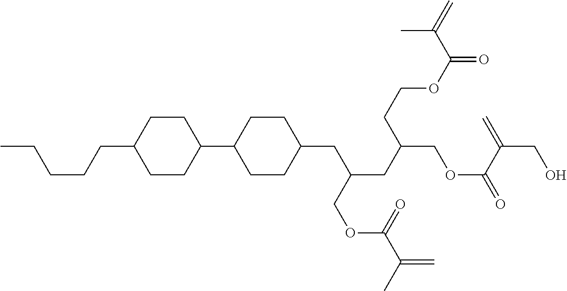 [SMILES: C=C(C)C(=O)OCCC(COC(=O)C(=C)CO)CC(COC(=O)C(=C)C)CC1CCC(C2CCC(CCCCC)CC2)CC1] |
| 1ϵ-4-131 | 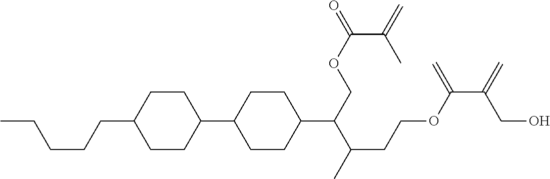 [SMILES: C=C(C)C(=O)OCC(C(C)CCOC(=C)C(=C)CO)C1CCC(C2CCC(CCCCC)CC2)CC1] |
| 1ϵ-4-132 | 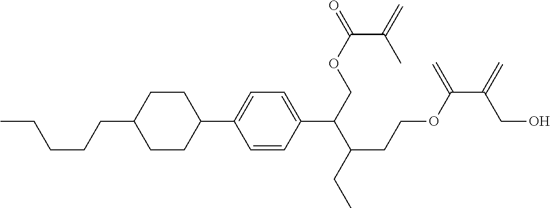 [SMILES: C=C(C)C(=O)OCC(c1ccc(C2CCC(CCCCC)CC2)cc1)C(CC)CCOC(=C)C(=C)CO] |
| 1ϵ-4-133 | 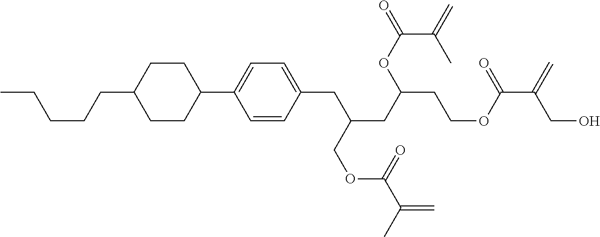 [SMILES: C=C(C)C(=O)OCC(Cc1ccc(C2CCC(CCCCC)CC2)cc1)CC(CCOC(=O)C(=C)CO)OC(=O)C(=C)C] |
| 1ϵ-4-134 | 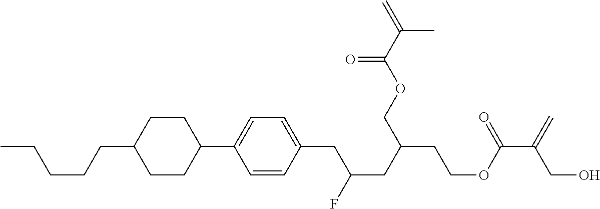 [SMILES: C=C(C)C(=O)OCC(CCOC(=O)C(=C)CO)CC(F)Cc1ccc(C2CCC(CCCCC)CC2)cc1] |
| 1ϵ-5-1 | 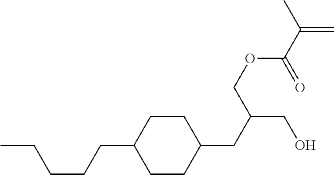 [SMILES: C=C(C)C(=O)OCC(CO)CC1CCC(CCCCC)CC1] |
| 1ϵ-5-2 | 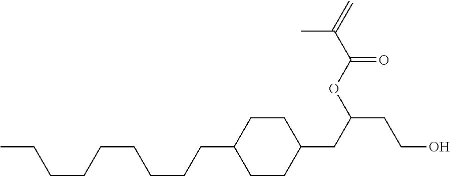 [SMILES: C=C(C)C(=O)OC(CCO)CC1CCC(CCCCCCCCC)CC1] |
| 1ϵ-5-3 | 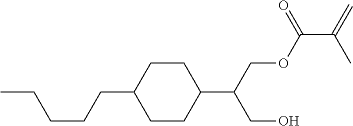 [SMILES: C=C(C)C(=O)OCC(CO)C1CCC(CCCCC)CC1] |
| 1ϵ-5-4 | 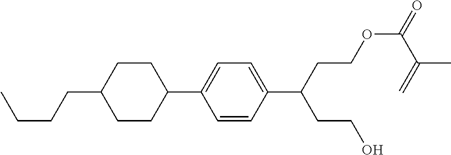 [SMILES: C=C(C)C(=O)OCCC(CCO)c1ccc(C2CCC(CCCC)CC2)cc1] |
| 1ϵ-5-5 | 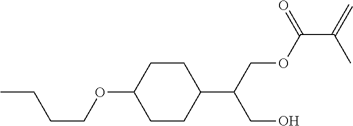 [SMILES: C=C(C)C(=O)OCC(CO)C1CCC(OCCCC)CC1] |
| 1ϵ-5-6 | 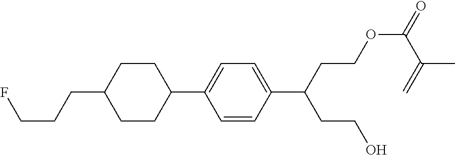 [SMILES: C=C(C)C(=O)OCCC(CCO)c1ccc(C2CCC(CCCF)CC2)cc1] |
| 1ϵ-5-7 | 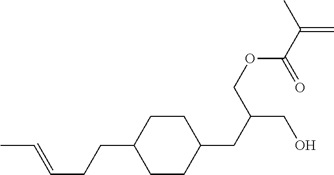 [SMILES: C=C(C)C(=O)OCC(CO)CC1CCC(CC/C=C/C)CC1] |
| 1ϵ-5-8 | 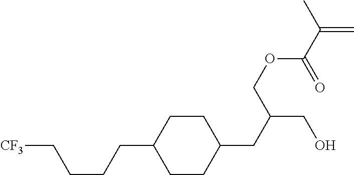 [SMILES: C=C(C)C(=O)OCC(CO)CC1CCC(CCCCC(F)(F)F)CC1] |
| 1ϵ-5-9 | 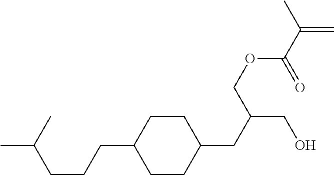 [SMILES: C=C(C)C(=O)OCC(CO)CC1CCC(CCCC(C)C)CC1] |
| 1ϵ-5-10 | 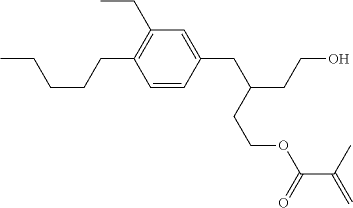 [SMILES: C=C(C)C(=O)OCCC(CCO)Cc1ccc(CCCCC)c(CC)c1] |
| 1ϵ-5-11 | 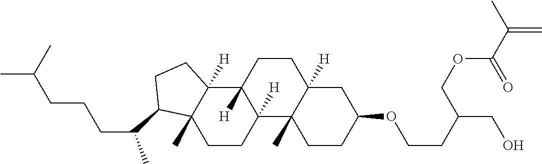 |
| 1ϵ-5-12 | 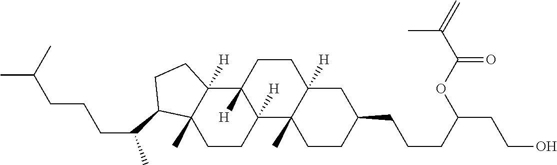 |
| 1ϵ-5-13 | 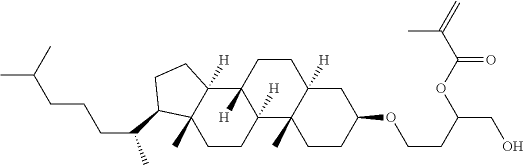 |
| 1ϵ-5-14 | 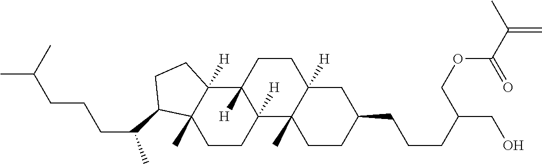 |
| 1ϵ-5-15 | 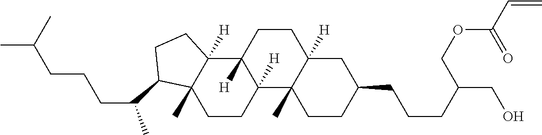 |
| 1ϵ-5-16 | 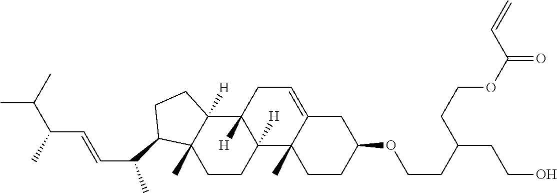 |
| 1ϵ-5-17 | 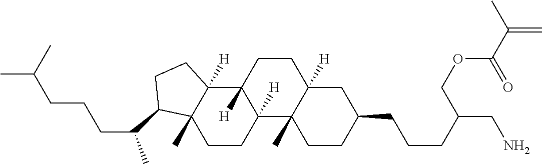 |
| 1ϵ-5-18 | 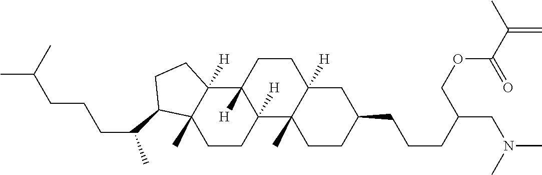 |
| 1ϵ-5-19 | 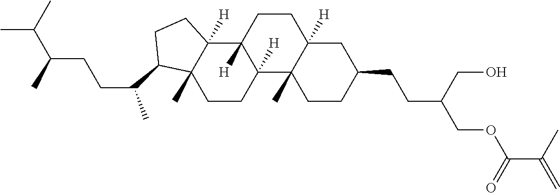 |
| 1ϵ-5-20 | 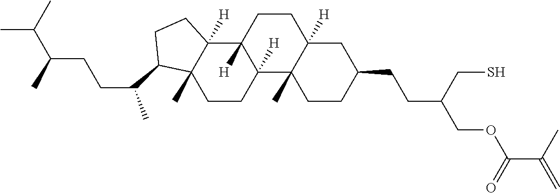 |
| 1ϵ-6-1 | 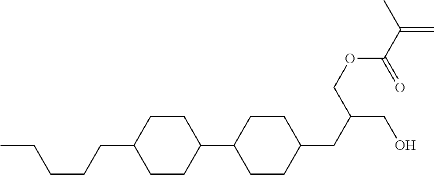 [SMILES: C=C(C)C(=O)OCC(CO)CC1CCC(C2CCC(CCCCC)CC2)CC1] |
| 1ϵ-6-2 | 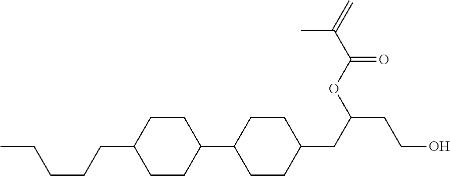 [SMILES: C=C(C)C(=O)OC(CCO)CC1CCC(C2CCC(CCCCC)CC2)CC1] |
| 1ϵ-6-3 | 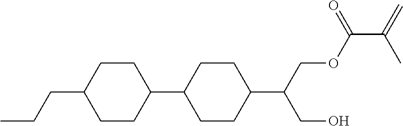 [SMILES: C=C(C)C(=O)OCC(CO)C1CCC(C2CCC(CCC)CC2)CC1] |
| 1ϵ-6-4 | 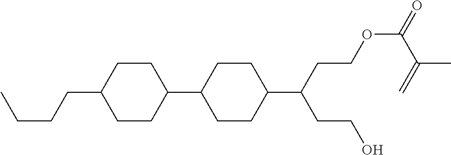 [SMILES: C=C(C)C(=O)OCCC(CCO)C1CCC(C2CCC(CCCC)CC2)CC1] |
| 1ϵ-6-5 | 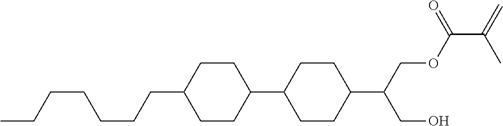 [SMILES: C=C(C)C(=O)OCC(CO)C1CCC(C2CCC(CCCCCCC)CC2)CC1] |
| 1ϵ-6-6 | 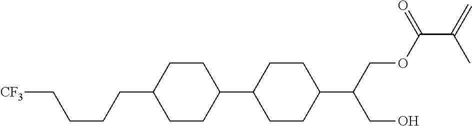 [SMILES: C=C(C)C(=O)OCC(CO)C1CCC(C2CCC(CCCCC(F)(F)F)CC2)CC1] |
| 1ϵ-6-7 | 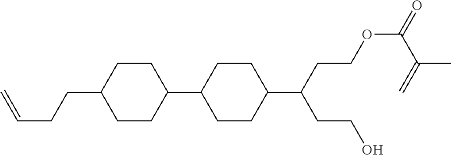 [SMILES: C=CCCC1CCC(C2CCC(C(CCO)CCOC(=O)C(=C)C)CC2)CC1] |
| 1ϵ-6-8 | 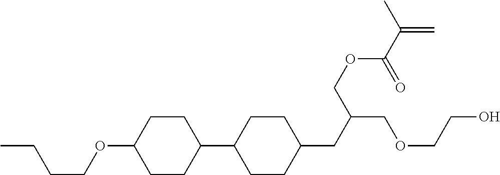 [SMILES: C=C(C)C(=O)OCC(COCCO)CC1CCC(C2CCC(OCCCC)CC2)CC1] |
| 1ϵ-6-9 | 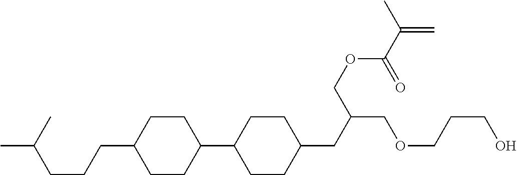 [SMILES: C=C(C)C(=O)OCC(COCCCO)CC1CCC(C2CCC(CCCC(C)C)CC2)CC1] |
| 1ϵ-6-10 | 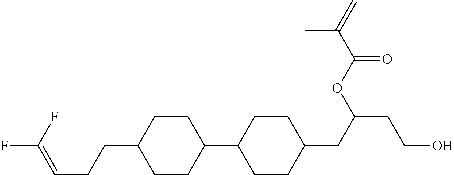 [SMILES: C=C(C)C(=O)OC(CCO)CC1CCC(C2CCC(CCC=C(F)F)CC2)CC1] |
| 1ϵ-6-11 | 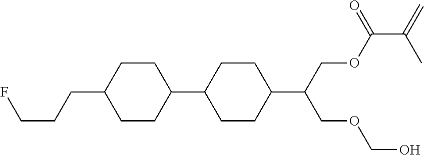 [SMILES: C=C(C)C(=O)OCC(COCO)C1CCC(C2CCC(CCCF)CC2)CC1] |
| 1ϵ-6-12 | 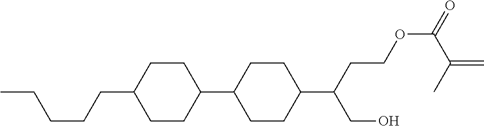 [SMILES: C=C(C)C(=O)OCCC(CO)C1CCC(C2CCC(CCCCC)CC2)CC1] |
| 1ϵ-6-13 | 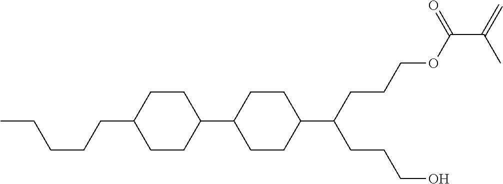 [SMILES: C=C(C)C(=O)OCCCC(CCCO)C1CCC(C2CCC(CCCCC)CC2)CC1] |
| 1ϵ-6-14 | 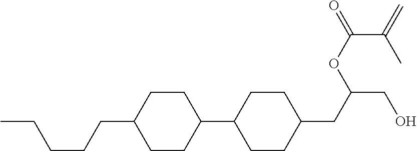 [SMILES: C=C(C)C(=O)OC(CO)CC1CCC(C2CCC(CCCCC)CC2)CC1] |
| 1ϵ-6-15 | 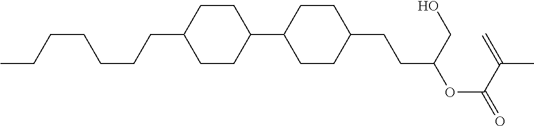 [SMILES: C=C(C)C(=O)OC(CO)CCC1CCC(C2CCC(CCCCCCC)CC2)CC1] |
| 1ϵ-6-16 | 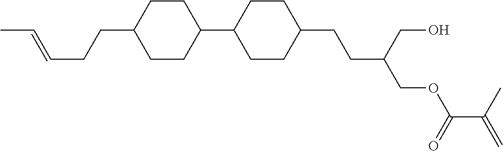 [SMILES: C=C(C)C(=O)OCC(CO)CCC1CCC(C2CCC(CC/C=C/C)CC2)CC1] |
| 1ϵ-6-17 | 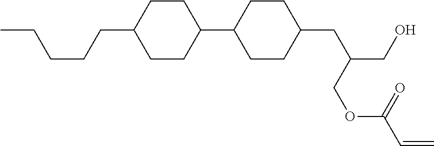 [SMILES: C=CC(=O)OCC(CO)CC1CCC(C2CCC(CCCCC)CC2)CC1] |
| 1ϵ-6-18 | 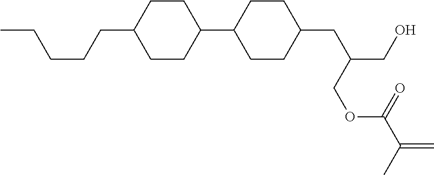 [SMILES: C=C(C)C(=O)OCC(CO)CC1CCC(C2CCC(CCCCC)CC2)CC1] |
| 1ϵ-6-19 | 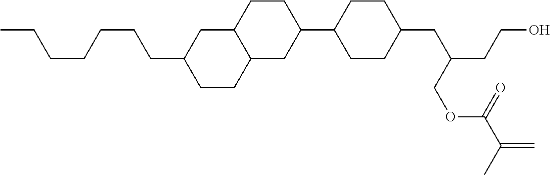 [SMILES: C=C(C)C(=O)OCC(CCO)CC1CCC(C2CCC3CC(CCCCCCC)CCC3C2)CC1] |
| 1ϵ-6-20 | 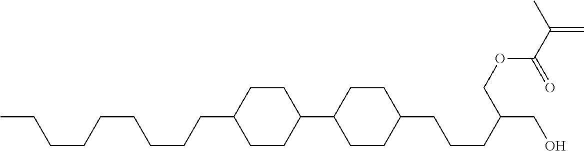 [SMILES: C=C(C)C(=O)OCC(CO)CCCC1CCC(C2CCC(CCCCCCCCC)CC2)CC1] |
| 1ϵ-6-21 | 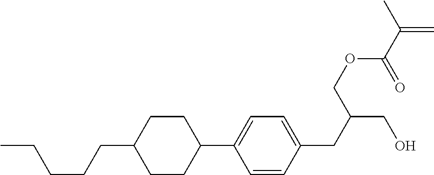 [SMILES: C=C(C)C(=O)OCC(CO)Cc1ccc(C2CCC(CCCCC)CC2)cc1] |
| 1ϵ-6-22 | 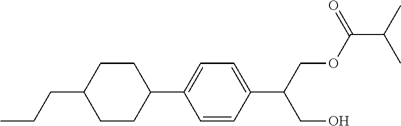 [SMILES: CCCC1CCC(c2ccc(C(CO)COC(=O)C(C)C)cc2)CC1] |
| 1ϵ-6-23 | 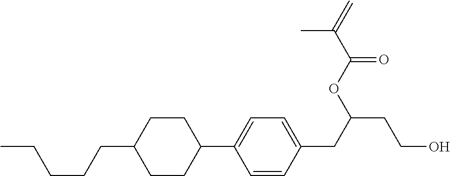 [SMILES: C=C(C)C(=O)OC(CCO)Cc1ccc(C2CCC(CCCCC)CC2)cc1] |
| 1ϵ-6-24 | 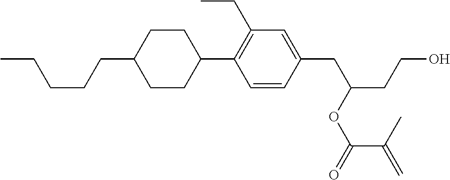 [SMILES: C=C(C)C(=O)OC(CCO)Cc1ccc(C2CCC(CCCCC)CC2)c(CC)c1] |
| 1ϵ-6-25 | 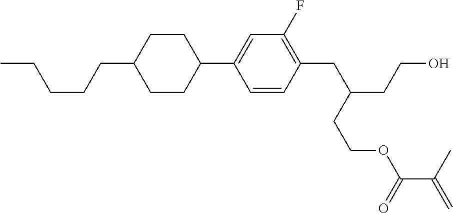 [SMILES: C=C(C)C(=O)OCCC(CCO)Cc1ccc(C2CCC(CCCCC)CC2)cc1F] |
| 1ϵ-6-26 | 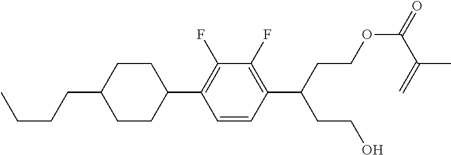 [SMILES: C=C(C)C(=O)OCCC(CCO)c1ccc(C2CCC(CCCC)CC2)c(F)c1F] |
| 1ϵ-6-27 | 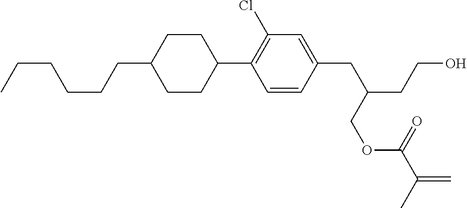 [SMILES: C=C(C)C(=O)OCC(CCO)Cc1ccc(C2CCC(CCCCCC)CC2)c(Cl)c1] |
| 1ϵ-6-28 | 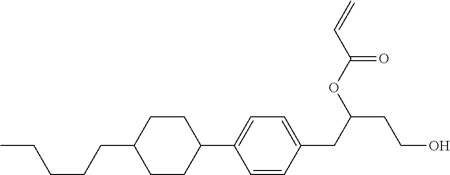 [SMILES: C=CC(=O)OC(CCO)Cc1ccc(C2CCC(CCCCC)CC2)cc1] |
| 1ϵ-6-29 | 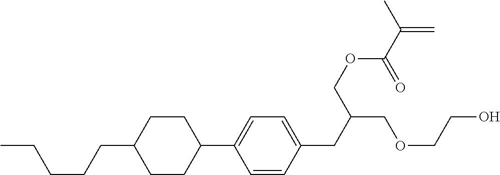 [SMILES: C=C(C)C(=O)OCC(COCCO)Cc1ccc(C2CCC(CCCCC)CC2)cc1] |
| 1ϵ-6-30 | 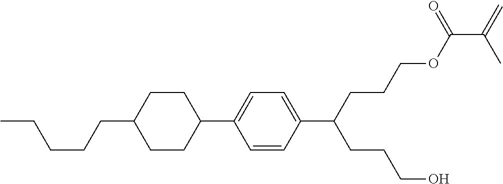 [SMILES: C=C(C)C(=O)OCCCC(CCCO)c1ccc(C2CCC(CCCCC)CC2)cc1] |
| 1ϵ-6-31 | 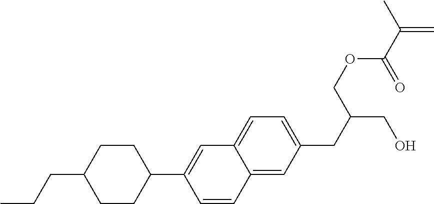 [SMILES: C=C(C)C(=O)OCC(CO)Cc1ccc2cc(C3CCC(CCC)CC3)ccc2c1] |
| 1ϵ-6-32 | 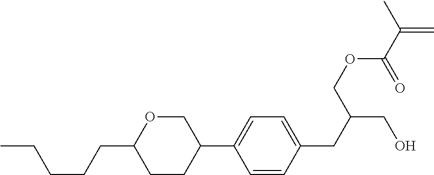 [SMILES: C=C(C)C(=O)OCC(CO)Cc1ccc(C2CCC(CCCCC)OC2)cc1] |
| 1ϵ-6-33 | 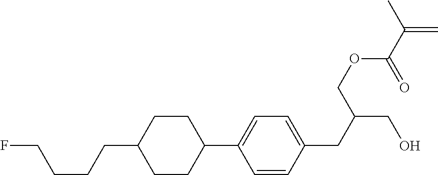 [SMILES: C=C(C)C(=O)OCC(CO)Cc1ccc(C2CCC(CCCCF)CC2)cc1] |
| 1ϵ-6-34 | 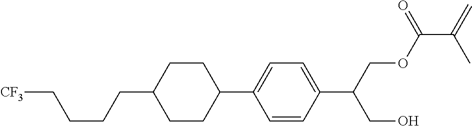 [SMILES: C=C(C)C(=O)OCC(CO)c1ccc(C2CCC(CCCCC(F)(F)F)CC2)cc1] |
| 1ϵ-6-35 | 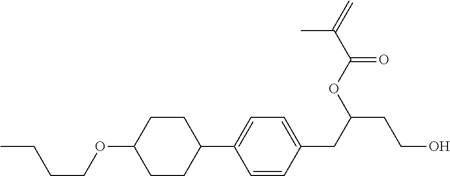 [SMILES: C=C(C)C(=O)OC(CCO)Cc1ccc(C2CCC(OCCCC)CC2)cc1] |
| 1ϵ-6-36 | 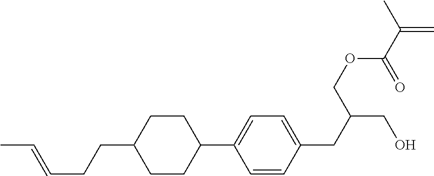 [SMILES: C=C(C)C(=O)OCC(CO)Cc1ccc(C2CCC(CC/C=C/C)CC2)cc1] |
| 1ϵ-6-37 | 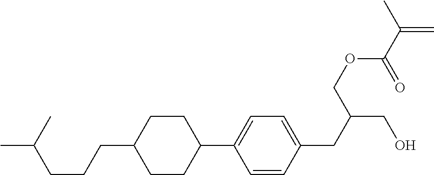 [SMILES: C=C(C)C(=O)OCC(CO)Cc1ccc(C2CCC(CCCC(C)C)CC2)cc1] |
| 1ϵ-6-38 | 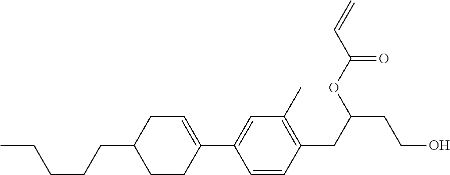 [SMILES: C=CC(=O)OC(CCO)Cc1ccc(C2=CCC(CCCCC)CC2)cc1C] |
| 1ϵ-6-39 | 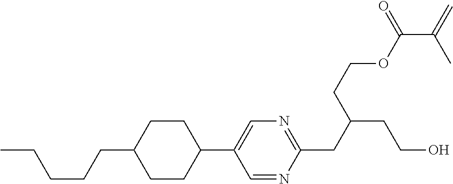 [SMILES: C=C(C)C(=O)OCCC(CCO)Cc1ncc(C2CCC(CCCCC)CC2)cn1] |
| 1ϵ-6-40 | 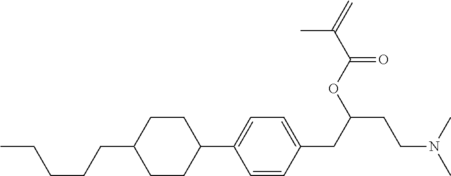 [SMILES: C=C(C)C(=O)OC(CCN(C)C)Cc1ccc(C2CCC(CCCCC)CC2)cc1] |
| 1ϵ-6-41 | 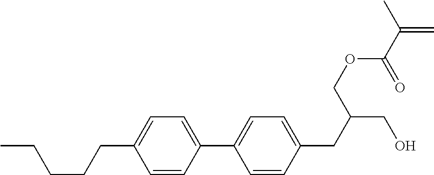 [SMILES: C=C(C)C(=O)OCC(CO)Cc1ccc(-c2ccc(CCCCC)cc2)cc1] |
| 1ϵ-6-42 | 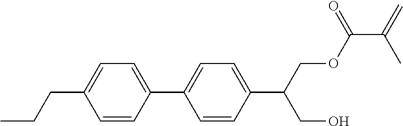 [SMILES: C=C(C)C(=O)OCC(CO)c1ccc(-c2ccc(CCC)cc2)cc1] |
| 1ϵ-6-43 | 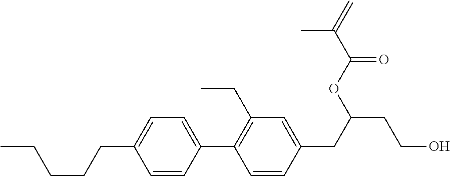 [SMILES: C=C(C)C(=O)OC(CCO)Cc1ccc(-c2ccc(CCCCC)cc2)c(CC)c1] |
| 1ϵ-6-44 | 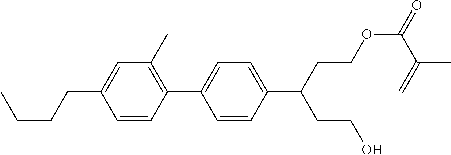 [SMILES: C=C(C)C(=O)OCCC(CCO)c1ccc(-c2ccc(CCCC)cc2C)cc1] |
| 1ϵ-6-45 | 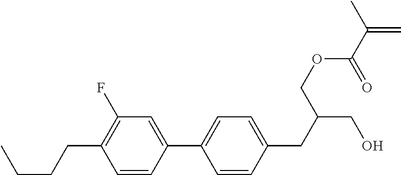 [SMILES: C=C(C)C(=O)OCC(CO)Cc1ccc(-c2ccc(CCCC)c(F)c2)cc1] |
| 1ϵ-6-46 | 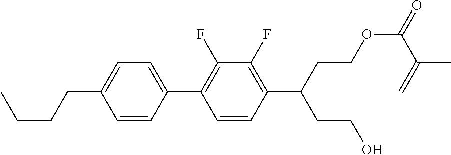 [SMILES: C=C(C)C(=O)OCCC(CCO)c1ccc(-c2ccc(CCCC)cc2)c(F)c1F] |
| 1ϵ-6-47 | 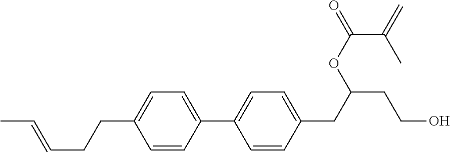 [SMILES: C=C(C)C(=O)OC(CCO)Cc1ccc(-c2ccc(CC/C=C/C)cc2)cc1] |
| 1ϵ-6-48 | 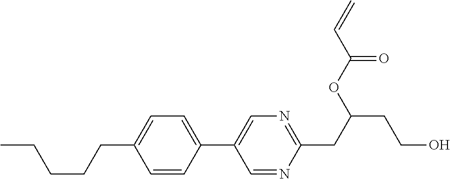 [SMILES: C=CC(=O)OC(CCO)Cc1ncc(-c2ccc(CCCCC)cc2)cn1] |
| 1ϵ-6-49 | 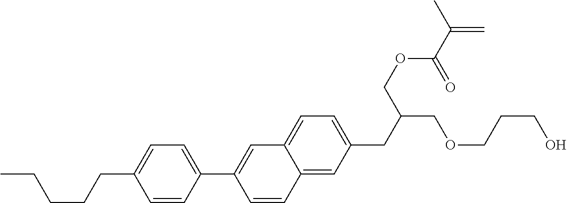 [SMILES: C=C(C)C(=O)OCC(COCCCO)Cc1ccc2cc(-c3ccc(CCCCC)cc3)ccc2c1] |
| 1ϵ-6-50 | 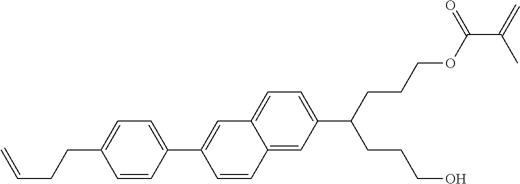 [SMILES: C=CCCc1ccc(-c2ccc3cc(C(CCCO)CCCOC(=O)C(=C)C)ccc3c2)cc1] |
| 1ϵ-6-51 | 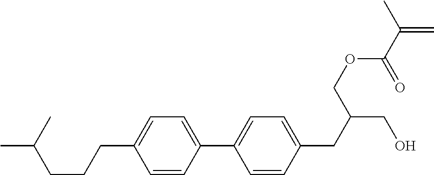 [SMILES: C=C(C)C(=O)OCC(CO)Cc1ccc(-c2ccc(CCCC(C)C)cc2)cc1] |
| 1ϵ-6-52 | 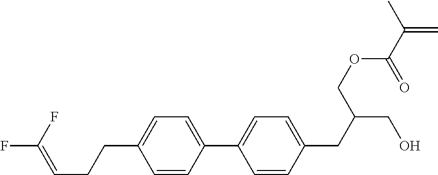 [SMILES: C=C(C)C(=O)OCC(CO)Cc1ccc(-c2ccc(CCC=C(F)F)cc2)cc1] |
| 1ϵ-6-53 | 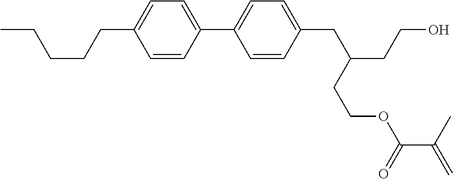 [SMILES: C=C(C)C(=O)OCCC(CCO)Cc1ccc(-c2ccc(CCCCC)cc2)cc1] |
| 1ϵ-6-54 | 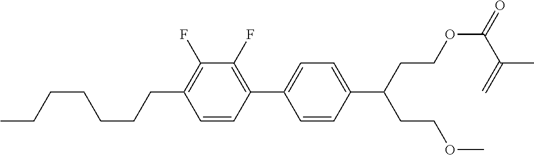 [SMILES: C=C(C)C(=O)OCCC(CCOC)c1ccc(-c2ccc(CCCCCCC)c(F)c2F)cc1] |
| 1ϵ-6-55 | 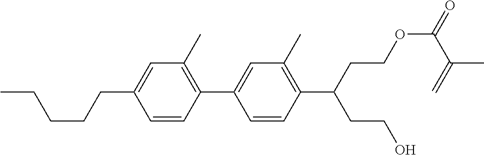 [SMILES: C=C(C)C(=O)OCCC(CCO)c1ccc(-c2ccc(CCCCC)cc2C)cc1C] |
| 1ϵ-6-56 | 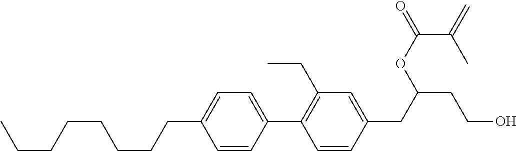 [SMILES: C=C(C)C(=O)OC(CCO)Cc1ccc(-c2ccc(CCCCCCCC)cc2)c(CC)c1] |
| 1ϵ-6-57 | 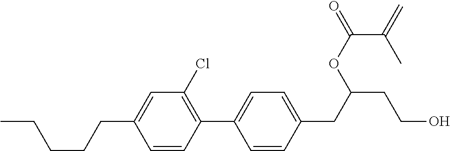 [SMILES: C=C(C)C(=O)OC(CCO)Cc1ccc(-c2ccc(CCCCC)cc2Cl)cc1] |
| 1ϵ-6-58 | 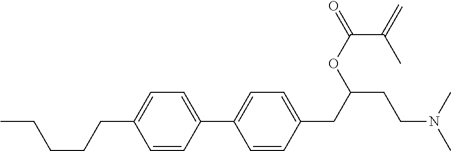 [SMILES: C=C(C)C(=O)OC(CCN(C)C)Cc1ccc(-c2ccc(CCCCC)cc2)cc1] |
| 1ϵ-6-59 | 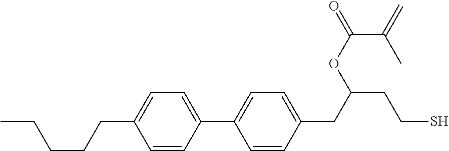 [SMILES: C=C(C)C(=O)OC(CCS)Cc1ccc(-c2ccc(CCCCC)cc2)cc1] |
| 1ϵ-6-60 | 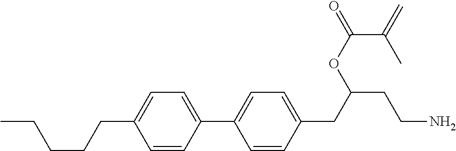 [SMILES: C=C(C)C(=O)OC(CCN)Cc1ccc(-c2ccc(CCCCC)cc2)cc1] |
| 1ϵ-6-61 | 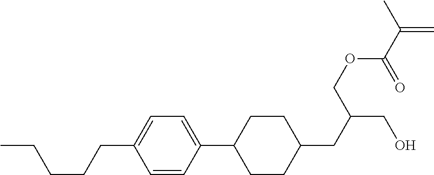 [SMILES: C=C(C)C(=O)OCC(CO)CC1CCC(c2ccc(CCCCC)cc2)CC1] |
| 1ϵ-6-62 | 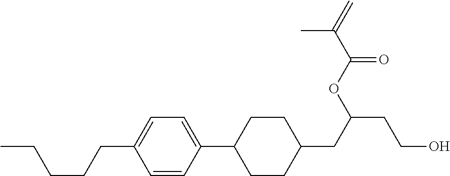 [SMILES: C=C(C)C(=O)OC(CCO)CC1CCC(c2ccc(CCCCC)cc2)CC1] |
| 1ϵ-6-63 | 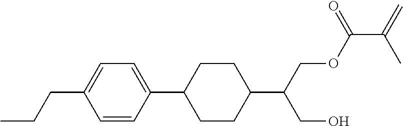 [SMILES: C=C(C)C(=O)OCC(CO)C1CCC(c2ccc(CCC)cc2)CC1] |
| 1ϵ-6-64 | 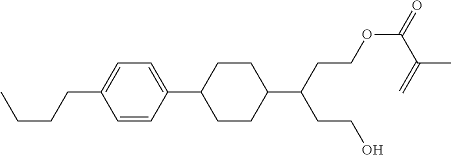 [SMILES: C=C(C)C(=O)OCCC(CCO)C1CCC(c2ccc(CCCC)cc2)CC1] |
| 1ϵ-6-65 | 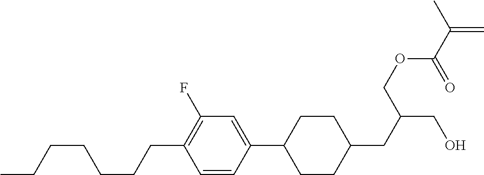 [SMILES: C=C(C)C(=O)OCC(CO)CC1CCC(c2ccc(CCCCCCC)c(F)c2)CC1] |
| 1ϵ-6-66 | 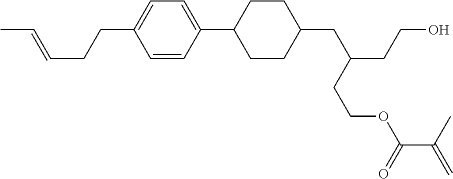 [SMILES: C=C(C)C(=O)OCCC(CCO)CC1CCC(c2ccc(CC/C=C/C)cc2)CC1] |
| 1ϵ-6-67 | 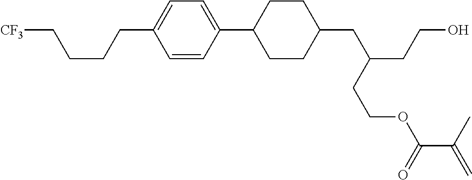 [SMILES: C=C(C)C(=O)OCCC(CCO)CC1CCC(c2ccc(CCCCC(F)(F)F)cc2)CC1] |
| 1ϵ-6-68 | 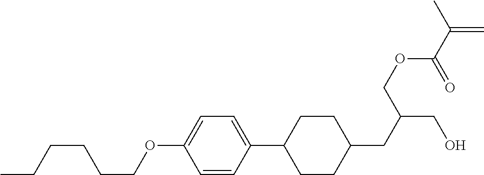 [SMILES: C=C(C)C(=O)OCC(CO)CC1CCC(c2ccc(OCCCCCC)cc2)CC1] |
| 1ϵ-6-69 | 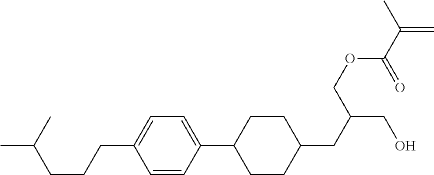 [SMILES: C=C(C)C(=O)OCC(CO)CC1CCC(c2ccc(CCCC(C)C)cc2)CC1] |
| 1ϵ-6-70 | 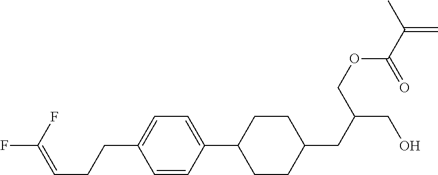 [SMILES: C=C(C)C(=O)OCC(CO)CC1CCC(c2ccc(CCC=C(F)F)cc2)CC1] |
| 1ϵ-6-71 | 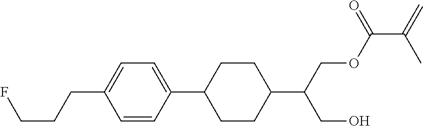 [SMILES: C=C(C)C(=O)OCC(CO)C1CCC(c2ccc(CCCF)cc2)CC1] |
| 1ϵ-6-72 | 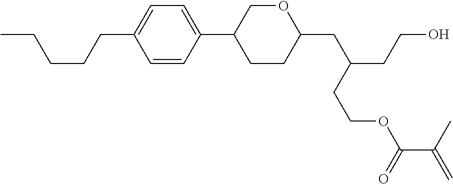 [SMILES: C=C(C)C(=O)OCCC(CCO)CC1CCC(c2ccc(CCCCC)cc2)CO1] |
| 1ϵ-6-73 | 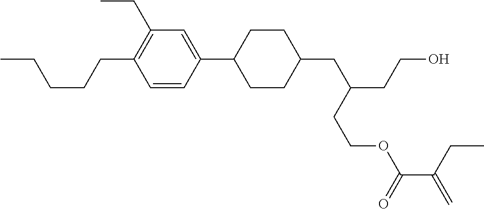 [SMILES: C=C(CC)C(=O)OCCC(CCO)CC1CCC(c2ccc(CCCCC)c(CC)c2)CC1] |
| 1ϵ-6-74 | 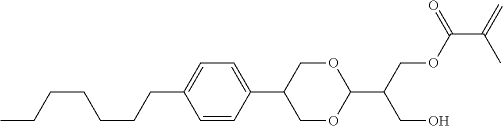 [SMILES: C=C(C)C(=O)OCC(CO)C1OCC(c2ccc(CCCCCCC)cc2)CO1] |
| 1ϵ-6-75 | 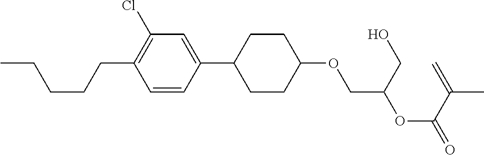 [SMILES: C=C(C)C(=O)OC(CO)COC1CCC(c2ccc(CCCCC)c(Cl)c2)CC1] |
| 1ϵ-6-76 | 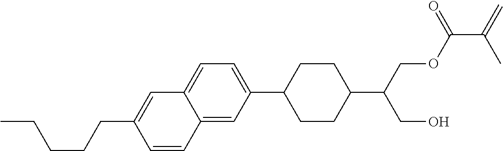 [SMILES: C=C(C)C(=O)OCC(CO)C1CCC(c2ccc3cc(CCCCC)ccc3c2)CC1] |
| 1ϵ-6-77 | 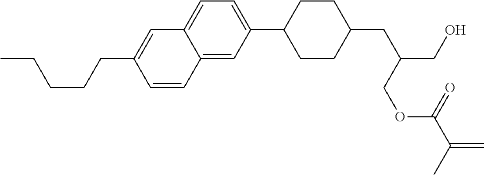 [SMILES: C=C(C)C(=O)OCC(CO)CC1CCC(c2ccc3cc(CCCCC)ccc3c2)CC1] |
| 1ϵ-6-78 | 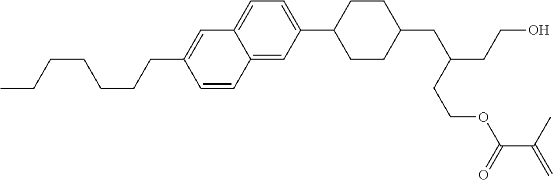 [SMILES: C=C(C)C(=O)OCCC(CCO)CC1CCC(c2ccc3cc(CCCCCCC)ccc3c2)CC1] |
| 1ϵ-6-79 | 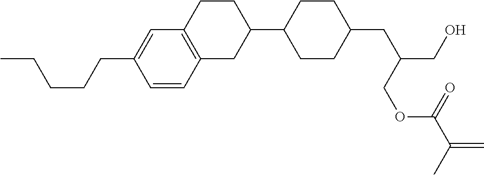 [SMILES: C=C(C)C(=O)OCC(CO)CC1CCC(C2CCc3cc(CCCCC)ccc3C2)CC1] |
| 1ϵ-6-80 | 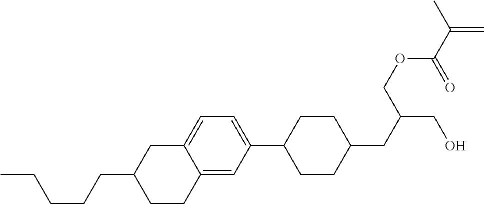 [SMILES: C=C(C)C(=O)OCC(CO)CC1CCC(c2ccc3c(c2)CCC(CCCCC)C3)CC1] |
| 1ϵ-6-81 | 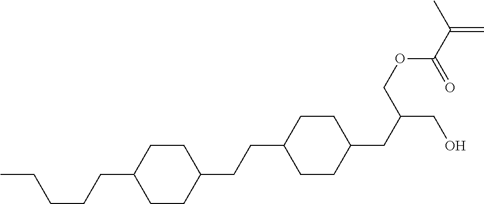 [SMILES: C=C(C)C(=O)OCC(CO)CC1CCC(CCC2CCC(CCCCC)CC2)CC1] |
| 1ϵ-6-82 | 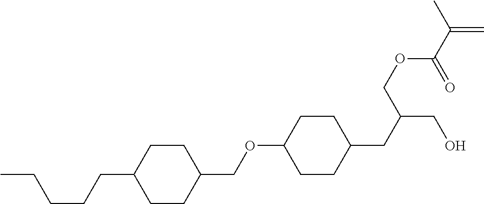 [SMILES: C=C(C)C(=O)OCC(CO)CC1CCC(OCC2CCC(CCCCC)CC2)CC1] |
| 1ϵ-6-83 | 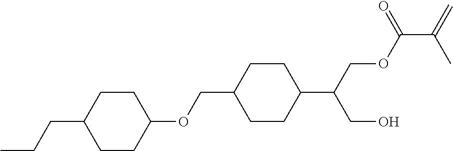 [SMILES: C=C(C)C(=O)OCC(CO)C1CCC(COC2CCC(CCC)CC2)CC1] |
| 1ϵ-6-84 | 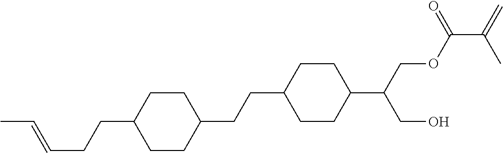 [SMILES: C=C(C)C(=O)OCC(CO)C1CCC(CCC2CCC(CC/C=C/C)CC2)CC1] |
| 1ϵ-6-85 | 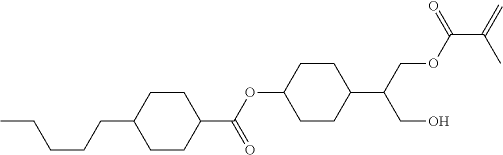 [SMILES: C=C(C)C(=O)OCC(CO)C1CCC(OC(=O)C2CCC(CCCCC)CC2)CC1] |
| 1ϵ-6-86 | 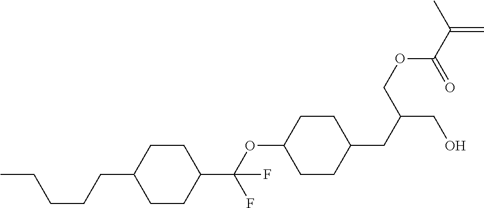 [SMILES: C=C(C)C(=O)OCC(CO)CC1CCC(OC(F)(F)C2CCC(CCCCC)CC2)CC1] |
| 1ϵ-6-87 | 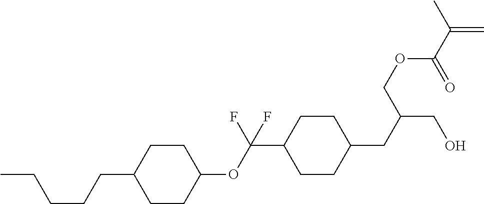 [SMILES: C=C(C)C(=O)OCC(CO)CC1CCC(C(F)(F)OC2CCC(CCCCC)CC2)CC1] |
| 1ϵ-6-88 | 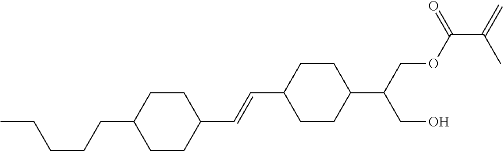 [SMILES: C=C(C)C(=O)OCC(CO)C1CCC(/C=C/C2CCC(CCCCC)CC2)CC1] |
| 1ϵ-6-89 | 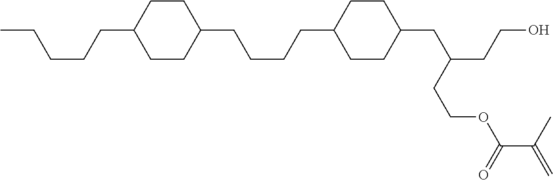 [SMILES: C=C(C)C(=O)OCCC(CCO)CC1CCC(CCCCC2CCC(CCCCC)CC2)CC1] |
| 1ϵ-6-90 | 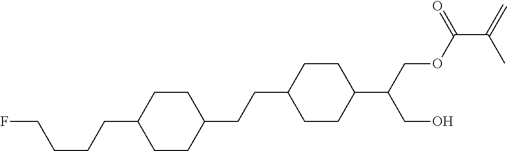 [SMILES: C=C(C)C(=O)OCC(CO)C1CCC(CCC2CCC(CCCCF)CC2)CC1] |
| 1ϵ-6-91 | 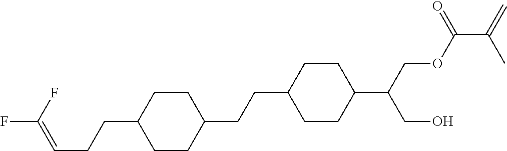 [SMILES: C=C(C)C(=O)OCC(CO)C1CCC(CCC2CCC(CCC=C(F)F)CC2)CC1] |
| 1ϵ-6-92 | 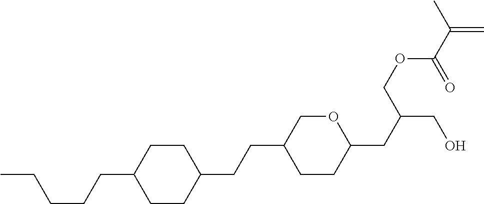 [SMILES: C=C(C)C(=O)OCC(CO)CC1CCC(CCC2CCC(CCCCC)CC2)CO1] |
| 1ϵ-6-93 | 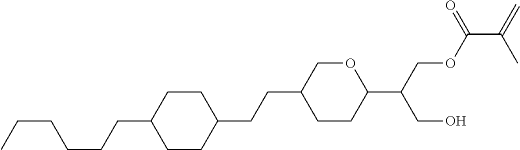 [SMILES: C=C(C)C(=O)OCC(CO)C1CCC(CCC2CCC(CCCCCC)CC2)CO1] |
| 1ϵ-6-94 | 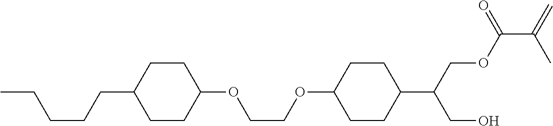 [SMILES: C=C(C)C(=O)OCC(CO)C1CCC(OCCOC2CCC(CCCCC)CC2)CC1] |
| 1ϵ-6-95 | 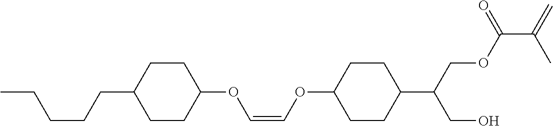 [SMILES: C=C(C)C(=O)OCC(CO)C1CCC(O/C=C\OC2CCC(CCCCC)CC2)CC1] |
| 1ϵ-6-96 | 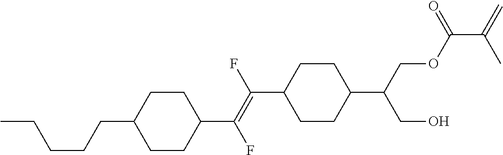 [SMILES: C=C(C)C(=O)OCC(CO)C1CCC(/C(F)=C(\F)C2CCC(CCCCC)CC2)CC1] |
| 1ϵ-6-97 | 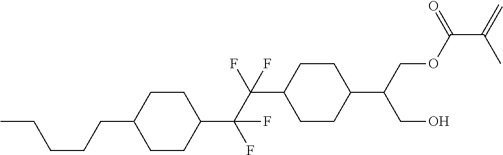 [SMILES: C=C(C)C(=O)OCC(CO)C1CCC(C(F)(F)C(F)(F)C2CCC(CCCCC)CC2)CC1] |
| 1ϵ-6-98 | 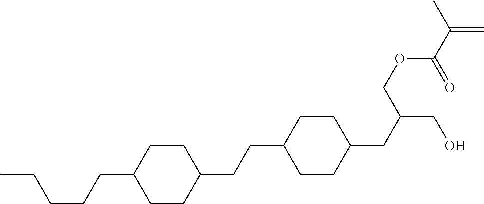 [SMILES: C=C(C)C(=O)OCC(CO)CC1CCC(CCC2CCC(CCCCC)CC2)CC1] |
| 1ϵ-6-99 | 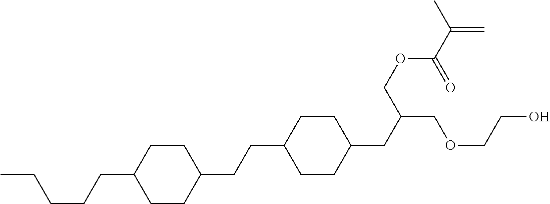 [SMILES: C=C(C)C(=O)OCC(COCCO)CC1CCC(CCC2CCC(CCCCC)CC2)CC1] |
| 1ϵ-6-100 | 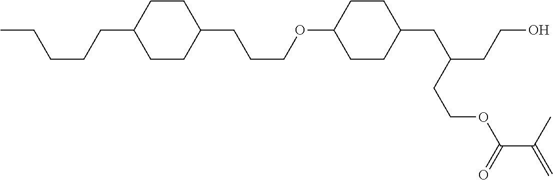 [SMILES: C=C(C)C(=O)OCCC(CCO)CC1CCC(OCCCC2CCC(CCCCC)CC2)CC1] |
| 1ϵ-6-101 | 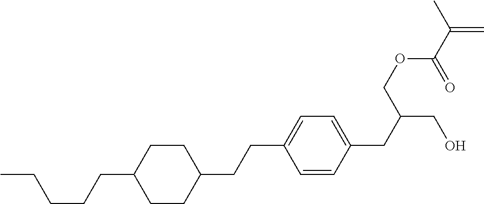 [SMILES: C=C(C)C(=O)OCC(CO)Cc1ccc(CCC2CCC(CCCCC)CC2)cc1] |
| 1ϵ-6-102 | 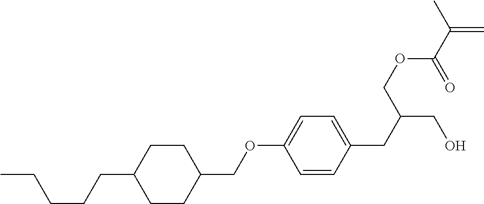 [SMILES: C=C(C)C(=O)OCC(CO)Cc1ccc(OCC2CCC(CCCCC)CC2)cc1] |
| 1ϵ-6-103 | 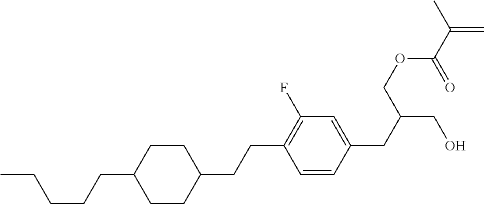 [SMILES: C=C(C)C(=O)OCC(CO)Cc1ccc(CCC2CCC(CCCCC)CC2)c(F)c1] |
| 1ϵ-6-104 | 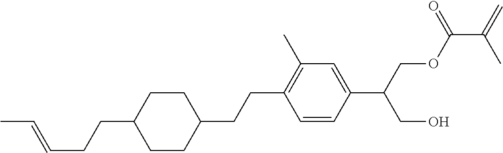 [SMILES: C=C(C)C(=O)OCC(CO)c1ccc(CCC2CCC(CC/C=C/C)CC2)c(C)c1] |
| 1ϵ-6-105 | 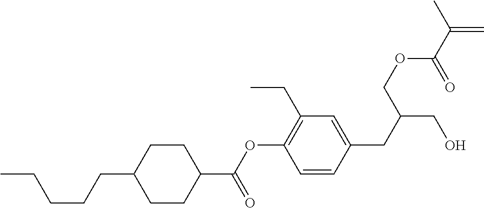 [SMILES: C=C(C)C(=O)OCC(CO)Cc1ccc(OC(=O)C2CCC(CCCCC)CC2)c(CC)c1] |
| 1ϵ-6-106 | 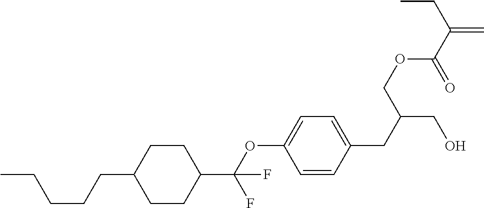 [SMILES: C=C(CC)C(=O)OCC(CO)Cc1ccc(OC(F)(F)C2CCC(CCCCC)CC2)cc1] |
| 1ϵ-6-107 | 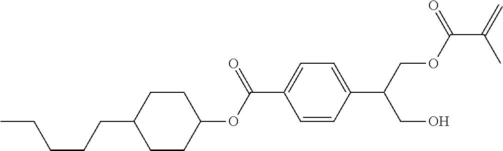 [SMILES: C=C(C)C(=O)OCC(CO)c1ccc(C(=O)OC2CCC(CCCCC)CC2)cc1] |
| 1ϵ-6-108 | 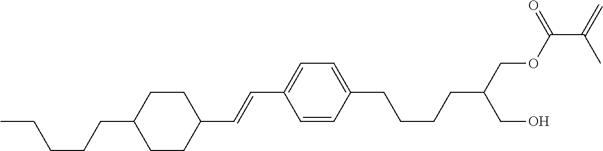 [SMILES: C=C(C)C(=O)OCC(CO)CCCCc1ccc(/C=C/C2CCC(CCCCC)CC2)cc1] |
| 1ϵ-6-109 | 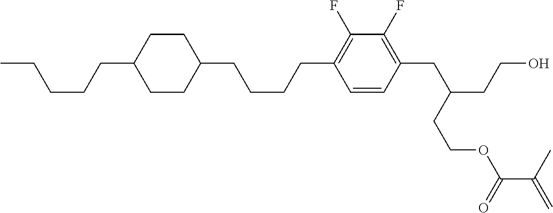 [SMILES: C=C(C)C(=O)OCCC(CCO)Cc1ccc(CCCCC2CCC(CCCCC)CC2)c(F)c1F] |
| 1ϵ-6-110 | 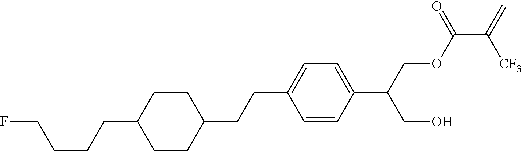 [SMILES: C=C(C(=O)OCC(CO)c1ccc(CCC2CCC(CCCCF)CC2)cc1)C(F)(F)F] |
| 1ϵ-6-111 | 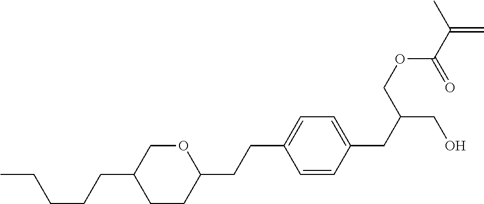 [SMILES: C=C(C)C(=O)OCC(CO)Cc1ccc(CCC2CCC(CCCCC)CO2)cc1] |
| 1ϵ-6-112 | 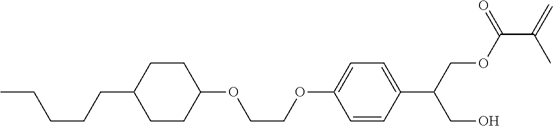 [SMILES: C=C(C)C(=O)OCC(CO)c1ccc(OCCOC2CCC(CCCCC)CC2)cc1] |
| 1ϵ-6-113 | 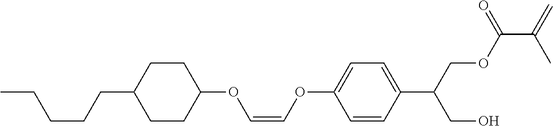 [SMILES: C=C(C)C(=O)OCC(CO)c1ccc(O/C=C\OC2CCC(CCCCC)CC2)cc1] |
| 1ϵ-6-114 | 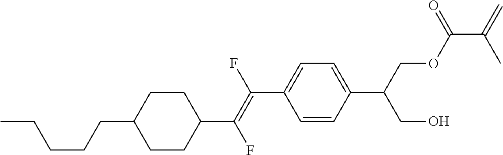 [SMILES: C=C(C)C(=O)OCC(CO)c1ccc(/C(F)=C(\F)C2CCC(CCCCC)CC2)cc1] |
| 1ϵ-6-115 | 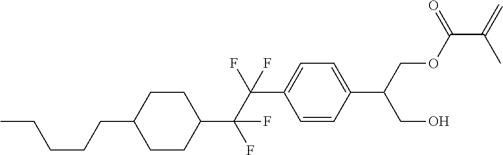 [SMILES: C=C(C)C(=O)OCC(CO)c1ccc(C(F)(F)C(F)(F)C2CCC(CCCCC)CC2)cc1] |
| 1ϵ-6-116 | 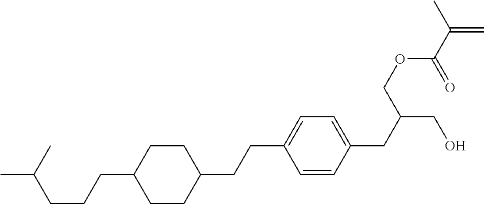 [SMILES: C=C(C)C(=O)OCC(CO)Cc1ccc(CCC2CCC(CCCC(C)C)CC2)cc1] |
| 1ϵ-6-117 | 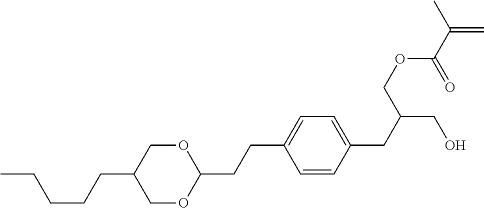 [SMILES: C=C(C)C(=O)OCC(CO)Cc1ccc(CCC2OCC(CCCCC)CO2)cc1] |
| 1ϵ-6-118 | 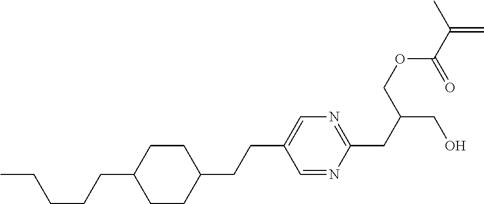 [SMILES: C=C(C)C(=O)OCC(CO)Cc1ncc(CCC2CCC(CCCCC)CC2)cn1] |
| 1ϵ-6-119 | 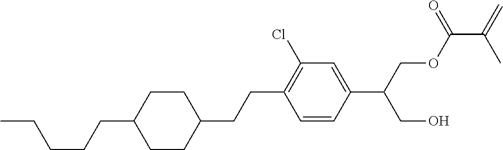 [SMILES: C=C(C)C(=O)OCC(CO)c1ccc(CCC2CCC(CCCCC)CC2)c(Cl)c1] |
| 1ϵ-6-120 | 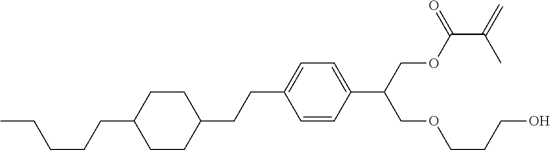 [SMILES: C=C(C)C(=O)OCC(COCCCO)c1ccc(CCC2CCC(CCCCC)CC2)cc1] |
| 1ϵ-6-121 | 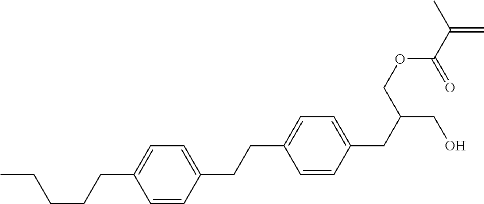 [SMILES: C=C(C)C(=O)OCC(CO)Cc1ccc(CCc2ccc(CCCCC)cc2)cc1] |
| 1ϵ-6-122 | 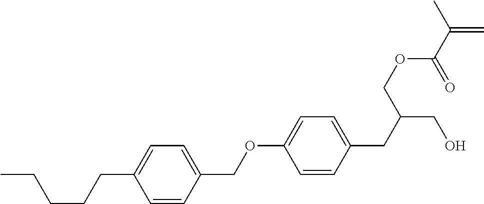 [SMILES: C=C(C)C(=O)OCC(CO)Cc1ccc(OCc2ccc(CCCCC)cc2)cc1] |
| 1ϵ-6-123 | 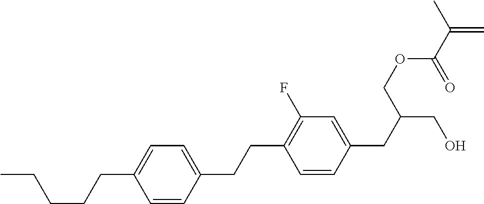 [SMILES: C=C(C)C(=O)OCC(CO)Cc1ccc(CCc2ccc(CCCCC)cc2)c(F)c1] |
| 1ϵ-6-124 | 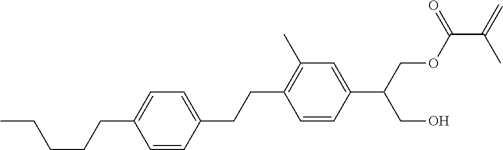 [SMILES: C=C(C)C(=O)OCC(CO)c1ccc(CCc2ccc(CCCCC)cc2)c(C)c1] |
| 1ϵ-6-125 | 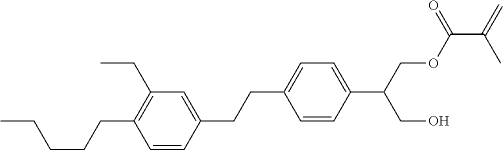 [SMILES: C=C(C)C(=O)OCC(CO)c1ccc(CCc2ccc(CCCCC)c(CC)c2)cc1] |
| 1ϵ-6-126 | 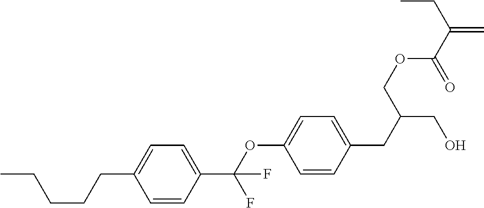 [SMILES: C=C(CC)C(=O)OCC(CO)Cc1ccc(OC(F)(F)c2ccc(CCCCC)cc2)cc1] |
| 1ϵ-6-127 | 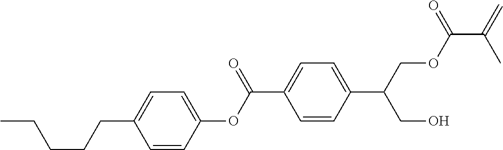 [SMILES: C=C(C)C(=O)OCC(CO)c1ccc(C(=O)Oc2ccc(CCCCC)cc2)cc1] |
| 1ϵ-6-128 | 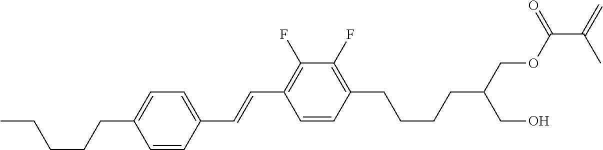 [SMILES: C=C(C)C(=O)OCC(CO)CCCCc1ccc(/C=C/c2ccc(CCCCC)cc2)c(F)c1F] |
| 1ϵ-6-129 | 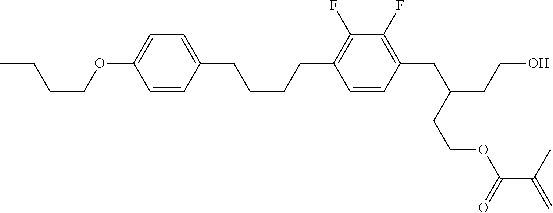 [SMILES: C=C(C)C(=O)OCCC(CCO)Cc1ccc(CCCCc2ccc(OCCCC)cc2)c(F)c1F] |
| 1ϵ-6-130 | 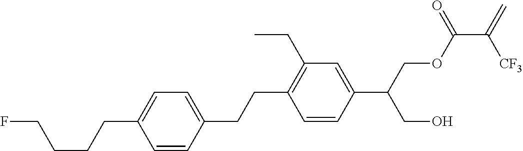 [SMILES: C=C(C(=O)OCC(CO)c1ccc(CCc2ccc(CCCCF)cc2)c(CC)c1)C(F)(F)F] |
| 1ϵ-6-131 | 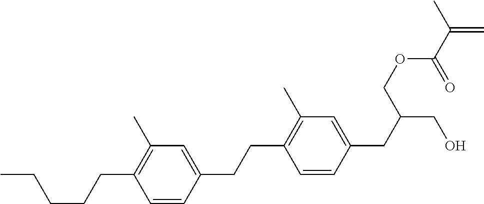 [SMILES: C=C(C)C(=O)OCC(CO)Cc1ccc(CCc2ccc(CCCCC)c(C)c2)c(C)c1] |
| 1ϵ-6-132 | 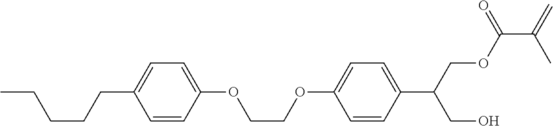 [SMILES: C=C(C)C(=O)OCC(CO)c1ccc(OCCOc2ccc(CCCCC)cc2)cc1] |
| 1ϵ-6-133 | 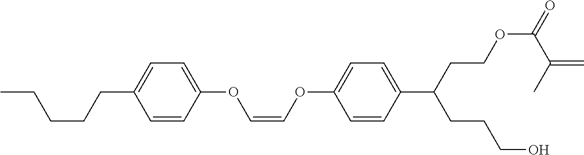 [SMILES: C=C(C)C(=O)OCCC(CCCO)c1ccc(O/C=C\Oc2ccc(CCCCC)cc2)cc1] |
| 1ϵ-6-134 | 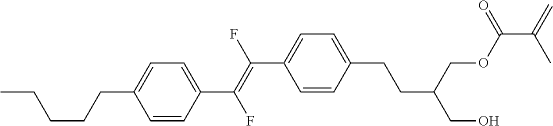 [SMILES: C=C(C)C(=O)OCC(CO)CCc1ccc(/C(F)=C(\F)c2ccc(CCCCC)cc2)cc1] |
| 1ϵ-6-135 | 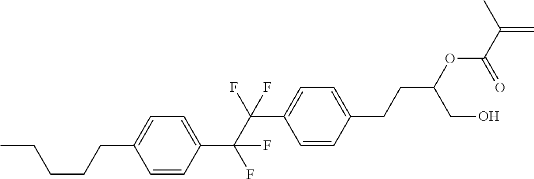 [SMILES: C=C(C)C(=O)OC(CO)CCc1ccc(C(F)(F)C(F)(F)c2ccc(CCCCC)cc2)cc1] |
| 1ϵ-6-136 | 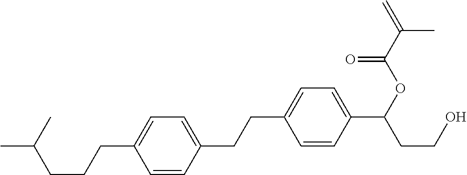 [SMILES: C=C(C)C(=O)OC(CCO)c1ccc(CCc2ccc(CCCC(C)C)cc2)cc1] |
| 1ϵ-6-137 | 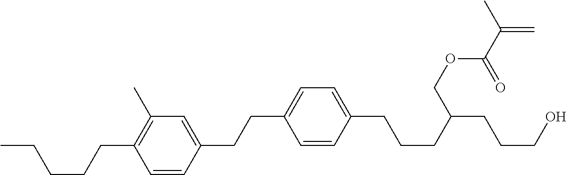 [SMILES: C=C(C)C(=O)OCC(CCCO)CCCc1ccc(CCc2ccc(CCCCC)c(C)c2)cc1] |
| 1ϵ-6-138 | 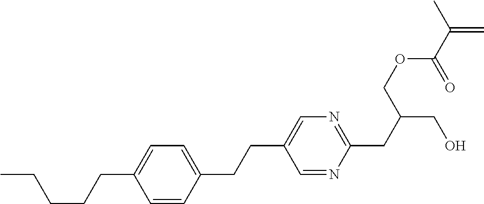 [SMILES: C=C(C)C(=O)OCC(CO)Cc1ncc(CCc2ccc(CCCCC)cc2)cn1] |
| 1ϵ-6-139 | 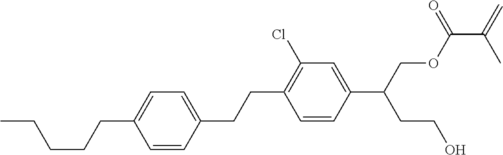 [SMILES: C=C(C)C(=O)OCC(CCO)c1ccc(CCc2ccc(CCCCC)cc2)c(Cl)c1] |
| 1ϵ-6-140 | 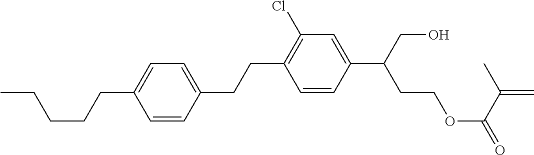 [SMILES: C=C(C)C(=O)OCCC(CO)c1ccc(CCc2ccc(CCCCC)cc2)c(Cl)c1] |
| 1ϵ-6-141 | 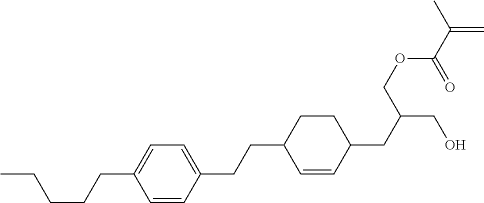 [SMILES: C=C(C)C(=O)OCC(CO)CC1C=CC(CCc2ccc(CCCCC)cc2)CC1] |
| 1ϵ-6-142 | 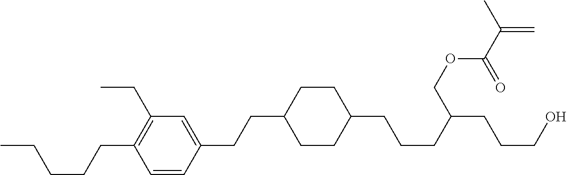 [SMILES: C=C(C)C(=O)OCC(CCCO)CCCC1CCC(CCc2ccc(CCCCC)c(CC)c2)CC1] |
| 1ϵ-6-143 | 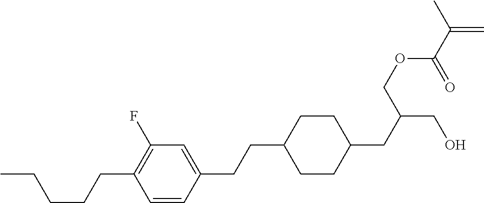 [SMILES: C=C(C)C(=O)OCC(CO)CC1CCC(CCc2ccc(CCCCC)c(F)c2)CC1] |
| 1ϵ-6-144 | 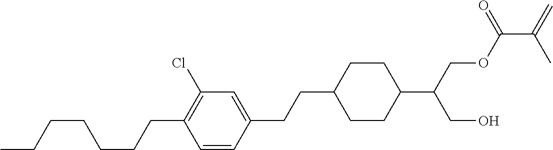 [SMILES: C=C(C)C(=O)OCC(CO)C1CCC(CCc2ccc(CCCCCCC)c(Cl)c2)CC1] |
| 1ϵ-6-145 | 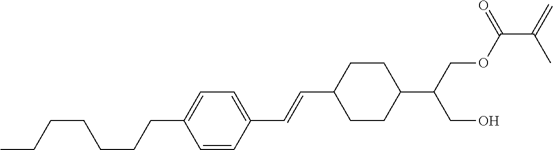 [SMILES: C=C(C)C(=O)OCC(CO)C1CCC(/C=C/c2ccc(CCCCCCC)cc2)CC1] |
| 1ϵ-6-146 | 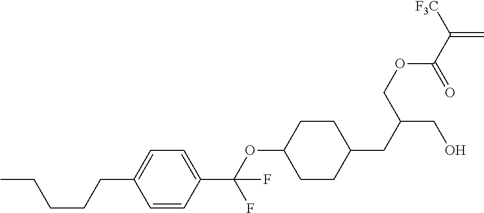 [SMILES: C=C(C(=O)OCC(CO)CC1CCC(OC(F)(F)c2ccc(CCCCC)cc2)CC1)C(F)(F)F] |
| 1ϵ-6-147 | 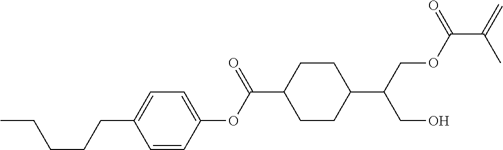 [SMILES: C=C(C)C(=O)OCC(CO)C1CCC(C(=O)Oc2ccc(CCCCC)cc2)CC1] |
| 1ϵ-6-148 | 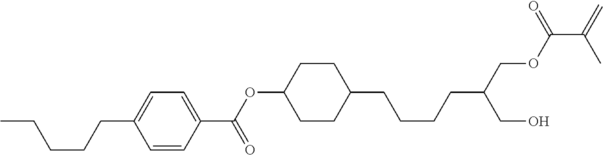 [SMILES: C=C(C)C(=O)OCC(CO)CCCCC1CCC(OC(=O)c2ccc(CCCCC)cc2)CC1] |
| 1ϵ-6-149 | 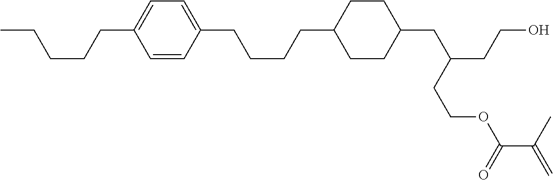 [SMILES: C=C(C)C(=O)OCCC(CCO)CC1CCC(CCCCc2ccc(CCCCC)cc2)CC1] |
| 1ϵ-6-150 | 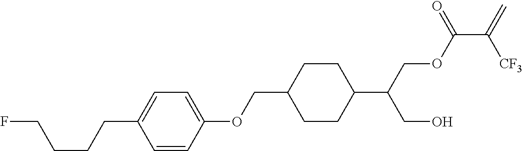 [SMILES: C=C(C(=O)OCC(CO)C1CCC(COc2ccc(CCCCF)cc2)CC1)C(F)(F)F] |
| 1ϵ-6-151 | 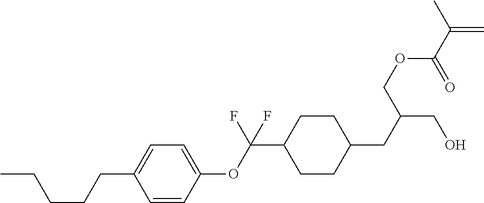 [SMILES: C=C(C)C(=O)OCC(CO)CC1CCC(C(F)(F)Oc2ccc(CCCCC)cc2)CC1] |
| 1ϵ-6-152 | 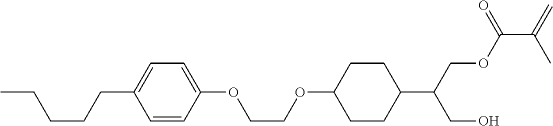 [SMILES: C=C(C)C(=O)OCC(CO)C1CCC(OCCOc2ccc(CCCCC)cc2)CC1] |
| 1ϵ-6-153 | 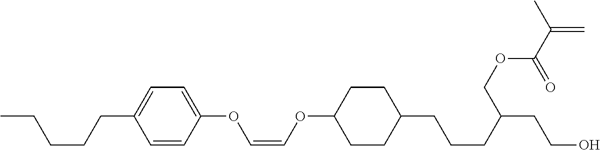 [SMILES: C=C(C)C(=O)OCC(CCO)CCCC1CCC(O/C=C\Oc2ccc(CCCCC)cc2)CC1] |
| 1ϵ-6-154 | 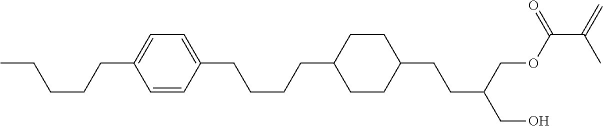 [SMILES: C=C(C)C(=O)OCC(CO)CCC1CCC(CCCCc2ccc(CCCCC)cc2)CC1] |
| 1ϵ-6-155 | 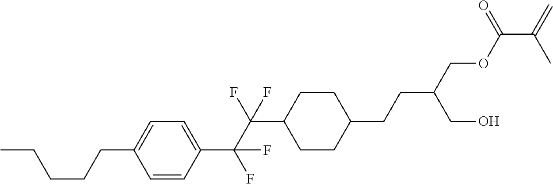 [SMILES: C=C(C)C(=O)OCC(CO)CCC1CCC(C(F)(F)C(F)(F)c2ccc(CCCCC)cc2)CC1] |
| 1ϵ-6-156 | 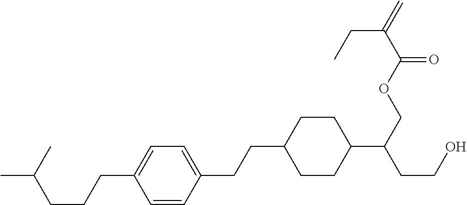 [SMILES: C=C(CC)C(=O)OCC(CCO)C1CCC(CCc2ccc(CCCC(C)C)cc2)CC1] |
| 1ϵ-6-157 | 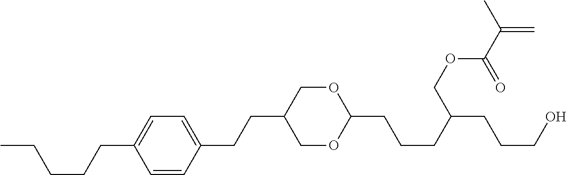 [SMILES: C=C(C)C(=O)OCC(CCCO)CCCC1OCC(CCc2ccc(CCCCC)cc2)CO1] |
| 1ϵ-6-158 | 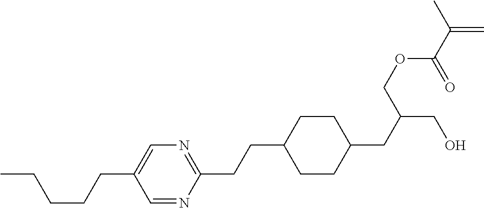 [SMILES: C=C(C)C(=O)OCC(CO)CC1CCC(CCc2ncc(CCCCC)cn2)CC1] |
| 1ϵ-6-159 | 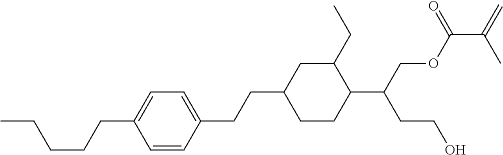 [SMILES: C=C(C)C(=O)OCC(CCO)C1CCC(CCc2ccc(CCCCC)cc2)CC1CC] |
| 1ϵ-6-160 | 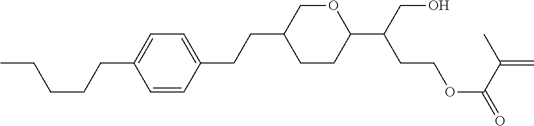 [SMILES: C=C(C)C(=O)OCCC(CO)C1CCC(CCc2ccc(CCCCC)cc2)CO1] |
| 1ϵ-6-161 | 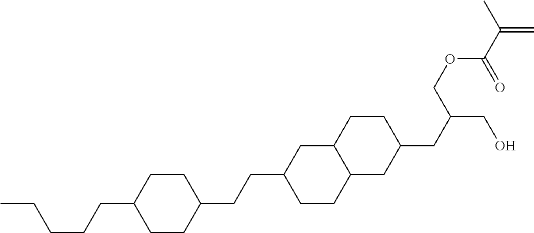 [SMILES: C=C(C)C(=O)OCC(CO)CC1CCC2CC(CCC3CCC(CCCCC)CC3)CCC2C1] |
| 1ϵ-6-162 | 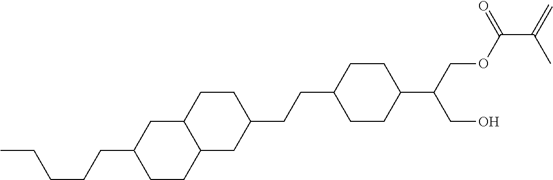 [SMILES: C=C(C)C(=O)OCC(CO)C1CCC(CCC2CCC3CC(CCCCC)CCC3C2)CC1] |
| 1ϵ-6-163 | 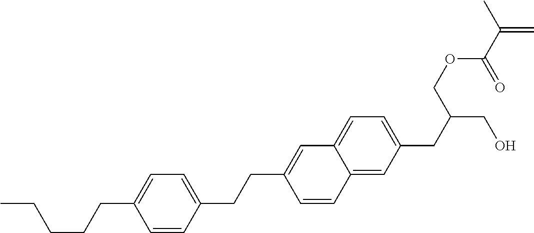 [SMILES: C=C(C)C(=O)OCC(CO)Cc1ccc2cc(CCc3ccc(CCCCC)cc3)ccc2c1] |
| 1ϵ-6-164 | 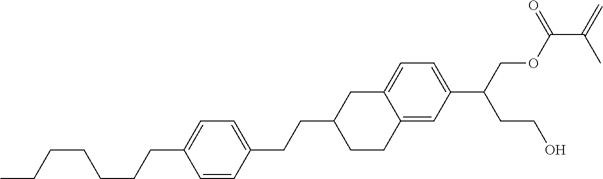 [SMILES: C=C(C)C(=O)OCC(CCO)c1ccc2c(c1)CCC(CCc1ccc(CCCCCCC)cc1)C2] |
| 1ϵ-6-165 | 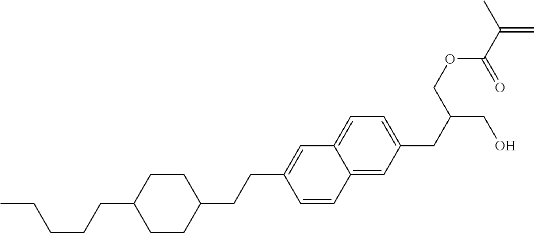 [SMILES: C=C(C)C(=O)OCC(CO)Cc1ccc2cc(CCC3CCC(CCCCC)CC3)ccc2c1] |
| 1ϵ-6-166 | 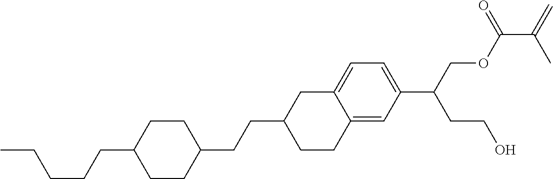 [SMILES: C=C(C)C(=O)OCC(CCO)c1ccc2c(c1)CCC(CCC1CCC(CCCCC)CC1)C2] |
| 1ϵ-6-167 | 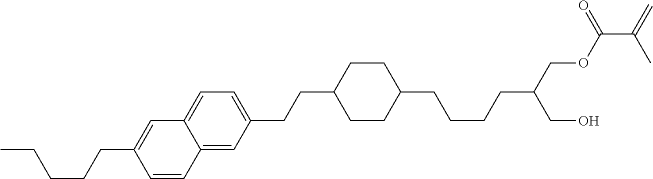 [SMILES: C=C(C)C(=O)OCC(CO)CCCCC1CCC(CCc2ccc3cc(CCCCC)ccc3c2)CC1] |
| 1ϵ-6-168 | 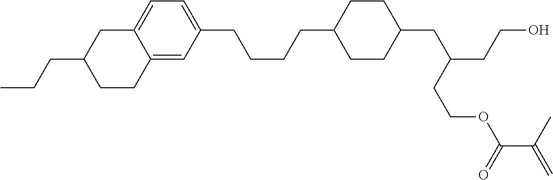 [SMILES: C=C(C)C(=O)OCCC(CCO)CC1CCC(CCCCc2ccc3c(c2)CCC(CCC)C3)CC1] |
| 1ϵ-6-169 | 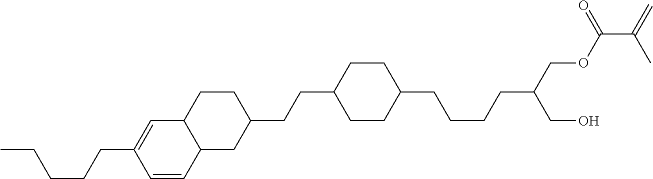 [SMILES: C=C(C)C(=O)OCC(CO)CCCCC1CCC(CCC2CCC3C=C(CCCCC)C=CC3C2)CC1] |
| 1ϵ-6-170 | 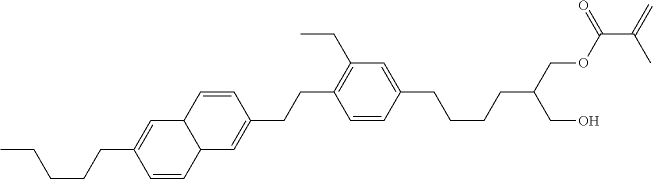 [SMILES: C=C(C)C(=O)OCC(CO)CCCCc1ccc(CCC2=CC3C=CC(CCCCC)=CC3C=C2)c(CC)c1] |
| 1ϵ-6-171 | 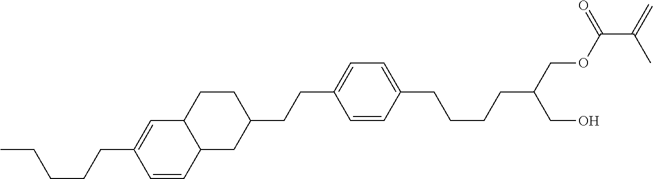 [SMILES: C=C(C)C(=O)OCC(CO)CCCCc1ccc(CCC2CCC3C=C(CCCCC)C=CC3C2)cc1] |
| 1ϵ-6-172 | 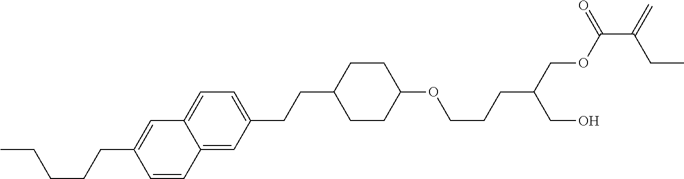 [SMILES: C=C(CC)C(=O)OCC(CO)CCCOC1CCC(CCc2ccc3cc(CCCCC)ccc3c2)CC1] |
| 1ϵ-6-173 | 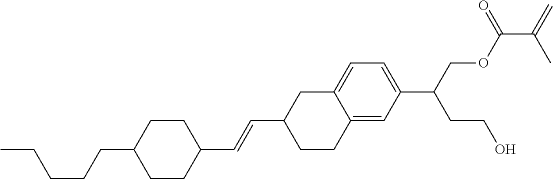 [SMILES: C=C(C)C(=O)OCC(CCO)c1ccc2c(c1)CCC(/C=C/C1CCC(CCCCC)CC1)C2] |
| 1ϵ-6-174 | 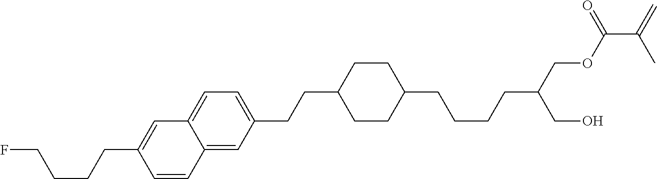 [SMILES: C=C(C)C(=O)OCC(CO)CCCCC1CCC(CCc2ccc3cc(CCCCF)ccc3c2)CC1] |
| 1ϵ-6-175 | 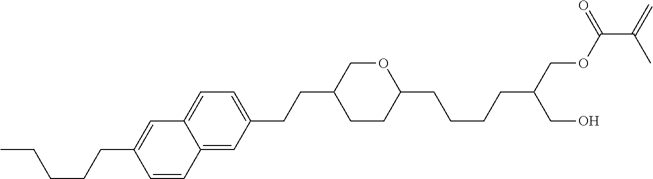 [SMILES: C=C(C)C(=O)OCC(CO)CCCCC1CCC(CCc2ccc3cc(CCCCC)ccc3c2)CO1] |
| 1ϵ-6-176 | 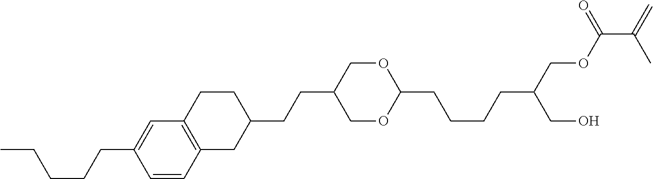 [SMILES: C=C(C)C(=O)OCC(CO)CCCCC1OCC(CCC2CCc3cc(CCCCC)ccc3C2)CO1] |
| 1ϵ-6-177 | 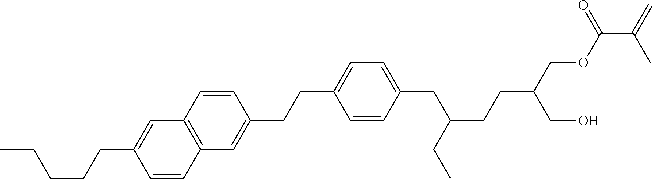 [SMILES: C=C(C)C(=O)OCC(CO)CCC(CC)Cc1ccc(CCc2ccc3cc(CCCCC)ccc3c2)cc1] |
| 1ϵ-6-178 | 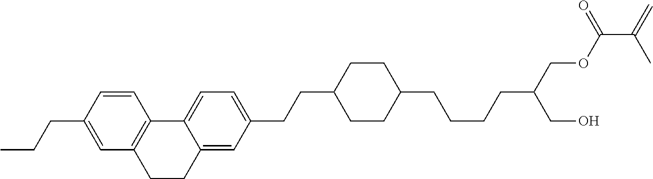 [SMILES: C=C(C)C(=O)OCC(CO)CCCCC1CCC(CCc2ccc3c(c2)CCc2cc(CCC)ccc2-3)CC1] |
| 1ϵ-6-179 | 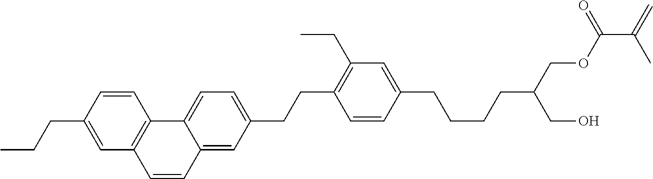 [SMILES: C=C(C)C(=O)OCC(CO)CCCCc1ccc(CCc2ccc3c(ccc4cc(CCC)ccc43)c2)c(CC)c1] |
| 1ϵ-6-180 | 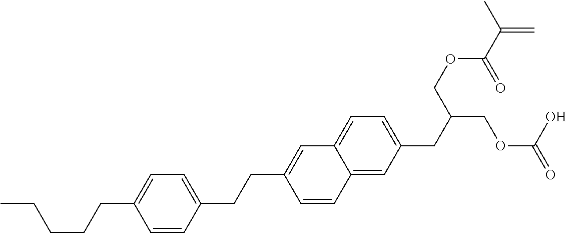 [SMILES: C=C(C)C(=O)OCC(COC(=O)O)Cc1ccc2cc(CCc3ccc(CCCCC)cc3)ccc2c1] |
| 1ϵ-7-1 | 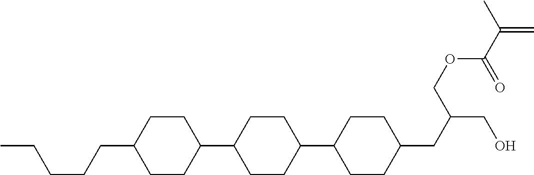 [SMILES: C=C(C)C(=O)OCC(CO)CC1CCC(C2CCC(C3CCC(CCCCC)CC3)CC2)CC1] |
| 1ϵ-7-2 | 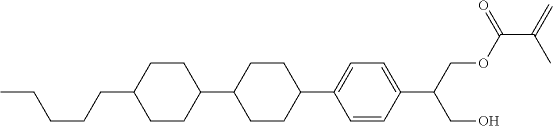 [SMILES: C=C(C)C(=O)OCC(CO)c1ccc(C2CCC(C3CCC(CCCCC)CC3)CC2)cc1] |
| 1ϵ-7-3 | 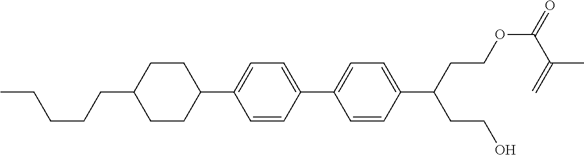 [SMILES: C=C(C)C(=O)OCCC(CCO)c1ccc(-c2ccc(C3CCC(CCCCC)CC3)cc2)cc1] |
| 1ϵ-7-4 | 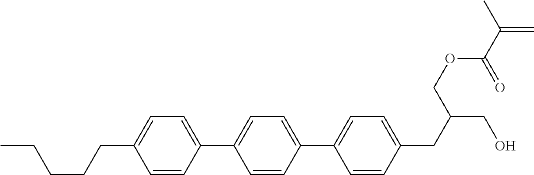 [SMILES: C=C(C)C(=O)OCC(CO)Cc1ccc(-c2ccc(-c3ccc(CCCCC)cc3)cc2)cc1] |
| 1ϵ-7-5 | 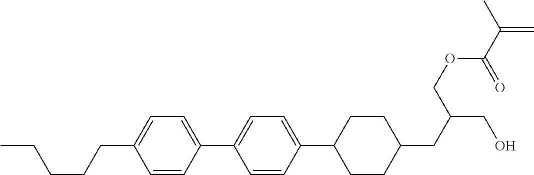 [SMILES: C=C(C)C(=O)OCC(CO)CC1CCC(c2ccc(-c3ccc(CCCCC)cc3)cc2)CC1] |
| 1ϵ-7-6 | 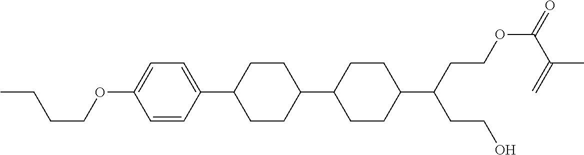 [SMILES: C=C(C)C(=O)OCCC(CCO)C1CCC(C2CCC(c3ccc(OCCCC)cc3)CC2)CC1] |
| 1ϵ-7-7 | 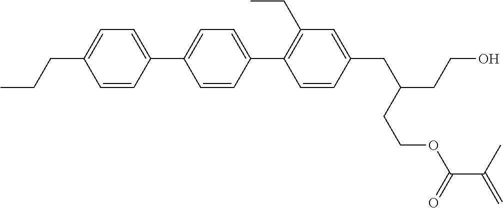 [SMILES: C=C(C)C(=O)OCCC(CCO)Cc1ccc(-c2ccc(-c3ccc(CCC)cc3)cc2)c(CC)c1] |
| 1ϵ-7-8 | 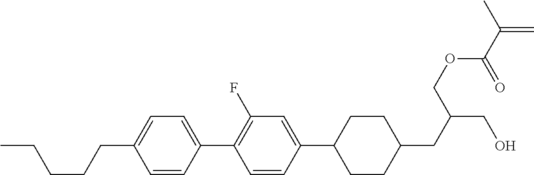 [SMILES: C=C(C)C(=O)OCC(CO)CC1CCC(c2ccc(-c3ccc(CCCCC)cc3)c(F)c2)CC1] |
| 1ϵ-7-9 | 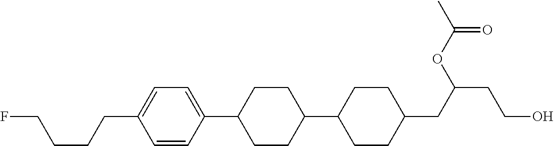 [SMILES: CC(=O)OC(CCO)CC1CCC(C2CCC(c3ccc(CCCCF)cc3)CC2)CC1] |
| 1ϵ-7-10 | 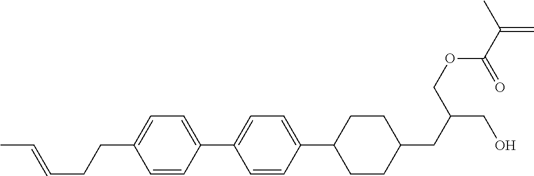 [SMILES: C=C(C)C(=O)OCC(CO)CC1CCC(c2ccc(-c3ccc(CC/C=C/C)cc3)cc2)CC1] |
| 1ϵ-7-11 | 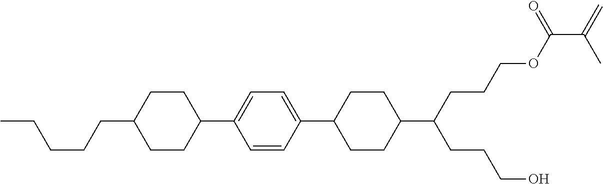 [SMILES: C=C(C)C(=O)OCCCC(CCCO)C1CCC(c2ccc(C3CCC(CCCCC)CC3)cc2)CC1] |
| 1ϵ-7-12 | 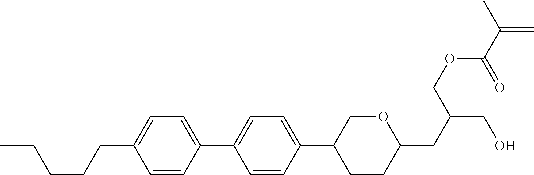 [SMILES: C=C(C)C(=O)OCC(CO)CC1CCC(c2ccc(-c3ccc(CCCCC)cc3)cc2)CO1] |
| 1ϵ-7-13 | 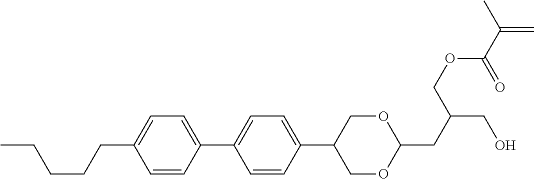 [SMILES: C=C(C)C(=O)OCC(CO)CC1OCC(c2ccc(-c3ccc(CCCCC)cc3)cc2)CO1] |
| 1ϵ-7-14 | 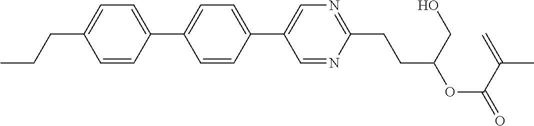 [SMILES: C=C(C)C(=O)OC(CO)CCc1ncc(-c2ccc(-c3ccc(CCC)cc3)cc2)cn1] |
| 1ϵ-7-15 | 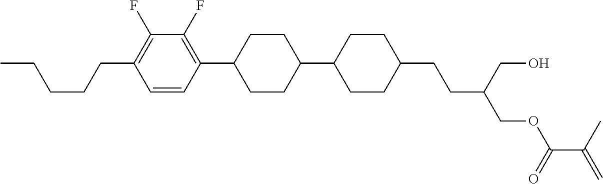 [SMILES: C=C(C)C(=O)OCC(CO)CCC1CCC(C2CCC(c3ccc(CCCCC)c(F)c3F)CC2)CC1] |
| 1ϵ-7-16 | 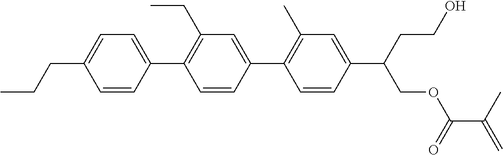 [SMILES: C=C(C)C(=O)OCC(CCO)c1ccc(-c2ccc(-c3ccc(CCC)cc3)c(CC)c2)c(C)c1] |
| 1ϵ-7-17 | 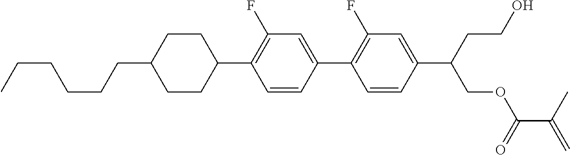 [SMILES: C=C(C)C(=O)OCC(CCO)c1ccc(-c2ccc(C3CCC(CCCCCC)CC3)c(F)c2)c(F)c1] |
| 1ϵ-7-18 | 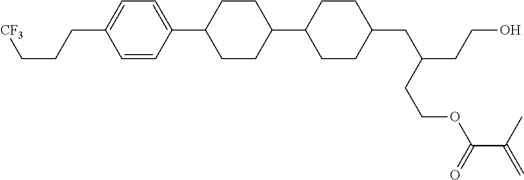 [SMILES: C=C(C)C(=O)OCCC(CCO)CC1CCC(C2CCC(c3ccc(CCCC(F)(F)F)cc3)CC2)CC1] |
| 1ϵ-7-19 | 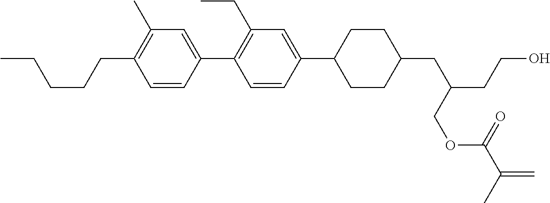 [SMILES: C=C(C)C(=O)OCC(CCO)CC1CCC(c2ccc(-c3ccc(CCCCC)c(C)c3)c(CC)c2)CC1] |
| 1ϵ-7-20 | 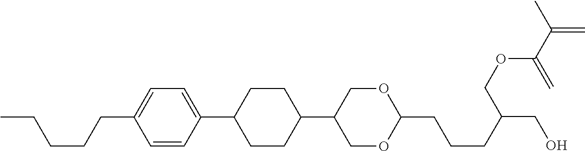 [SMILES: C=C(C)C(=C)OCC(CO)CCCC1OCC(C2CCC(c3ccc(CCCCC)cc3)CC2)CO1] |
| 1ϵ-7-21 | 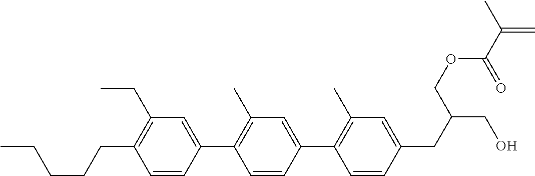 [SMILES: C=C(C)C(=O)OCC(CO)Cc1ccc(-c2ccc(-c3ccc(CCCCC)c(CC)c3)c(C)c2)c(C)c1] |
| 1ϵ-7-22 | 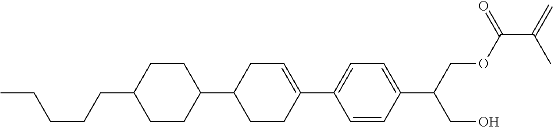 [SMILES: C=C(C)C(=O)OCC(CO)c1ccc(C2=CCC(C3CCC(CCCCC)CC3)CC2)cc1] |
| 1ϵ-7-23 | 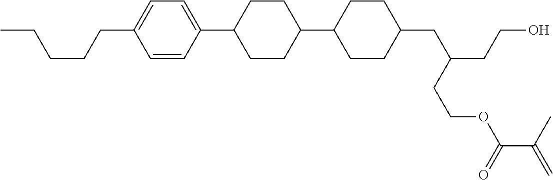 [SMILES: C=C(C)C(=O)OCCC(CCO)CC1CCC(C2CCC(c3ccc(CCCCC)cc3)CC2)CC1] |
| 1ϵ-7-24 | 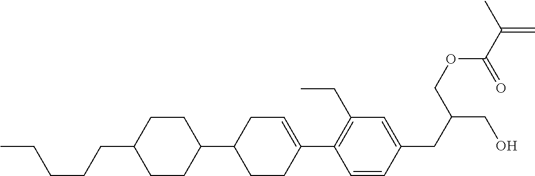 [SMILES: C=C(C)C(=O)OCC(CO)Cc1ccc(C2=CCC(C3CCC(CCCCC)CC3)CC2)c(CC)c1] |
| 1ϵ-7-25 | 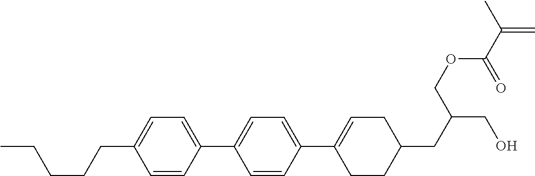 [SMILES: C=C(C)C(=O)OCC(CO)CC1CC=C(c2ccc(-c3ccc(CCCCC)cc3)cc2)CC1] |
| 1ϵ-7-26 | 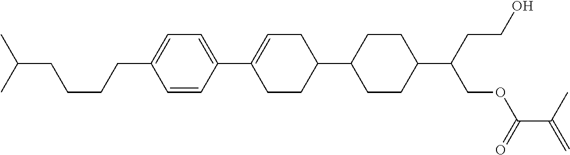 [SMILES: C=C(C)C(=O)OCC(CCO)C1CCC(C2CC=C(c3ccc(CCCCC(C)C)cc3)CC2)CC1] |
| 1ϵ-7-27 | 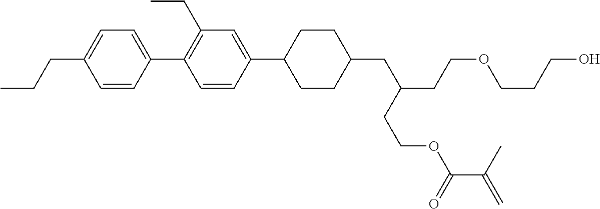 [SMILES: C=C(C)C(=O)OCCC(CCOCCCO)CC1CCC(c2ccc(-c3ccc(CCC)cc3)c(CC)c2)CC1] |
| 1ϵ-7-28 | 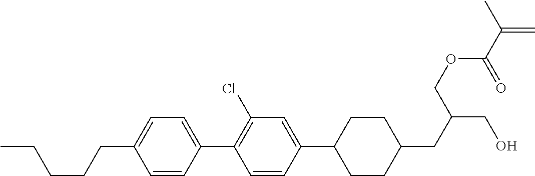 [SMILES: C=C(C)C(=O)OCC(CO)CC1CCC(c2ccc(-c3ccc(CCCCC)cc3)c(Cl)c2)CC1] |
| 1ϵ-7-29 | 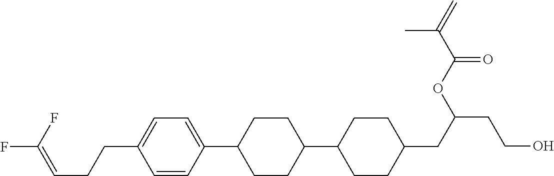 [SMILES: C=C(C)C(=O)OC(CCO)CC1CCC(C2CCC(c3ccc(CCC=C(F)F)cc3)CC2)CC1] |
| 1ϵ-7-30 | 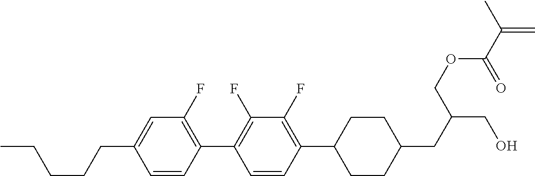 [SMILES: C=C(C)C(=O)OCC(CO)CC1CCC(c2ccc(-c3ccc(CCCCC)cc3F)c(F)c2F)CC1] |
| 1ϵ-7-31 | 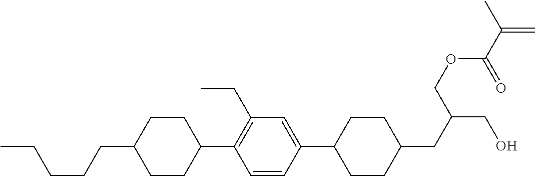 [SMILES: C=C(C)C(=O)OCC(CO)CC1CCC(c2ccc(C3CCC(CCCCC)CC3)c(CC)c2)CC1] |
| 1ϵ-7-32 | 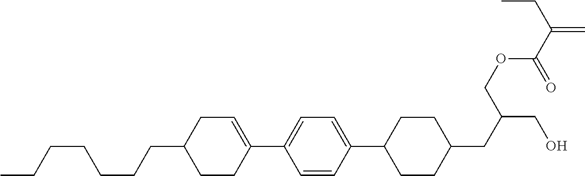 [SMILES: C=C(CC)C(=O)OCC(CO)CC1CCC(c2ccc(C3=CCC(CCCCCCC)CC3)cc2)CC1] |
| 1ϵ-7-33 | 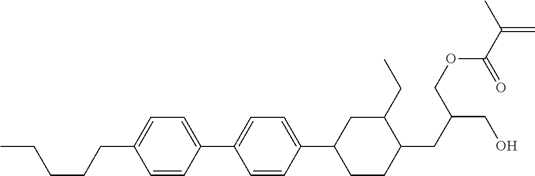 [SMILES: C=C(C)C(=O)OCC(CO)CC1CCC(c2ccc(-c3ccc(CCCCC)cc3)cc2)CC1CC] |
| 1ϵ-7-34 | 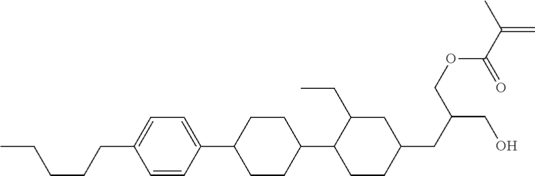 [SMILES: C=C(C)C(=O)OCC(CO)CC1CCC(C2CCC(c3ccc(CCCCC)cc3)CC2)C(CC)C1] |
| 1ϵ-7-35 | 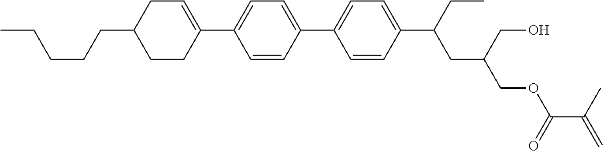 [SMILES: C=C(C)C(=O)OCC(CO)CC(CC)c1ccc(-c2ccc(C3=CCC(CCCCC)CC3)cc2)cc1] |
| 1ϵ-7-36 | 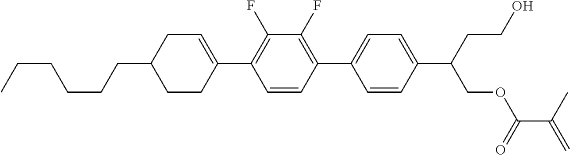 [SMILES: C=C(C)C(=O)OCC(CCO)c1ccc(-c2ccc(C3=CCC(CCCCCC)CC3)c(F)c2F)cc1] |
| 1ϵ-7-37 | 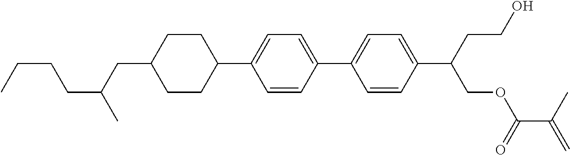 [SMILES: C=C(C)C(=O)OCC(CCO)c1ccc(-c2ccc(C3CCC(CC(C)CCCC)CC3)cc2)cc1] |
| 1ϵ-7-38 | 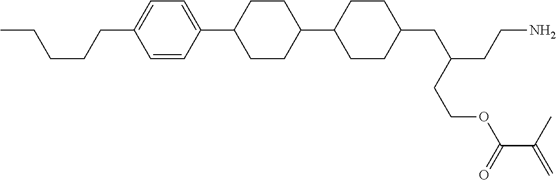 [SMILES: C=C(C)C(=O)OCCC(CCN)CC1CCC(C2CCC(c3ccc(CCCCC)cc3)CC2)CC1] |
| 1ϵ-7-39 | 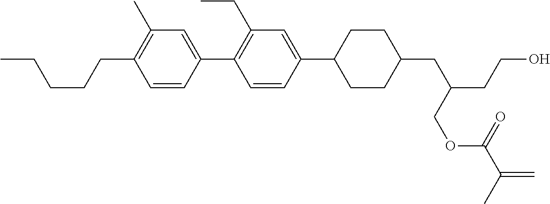 [SMILES: C=C(C)C(=O)OCC(CCO)CC1CCC(c2ccc(-c3ccc(CCCCC)c(C)c3)c(CC)c2)CC1] |
| 1ϵ-7-40 | 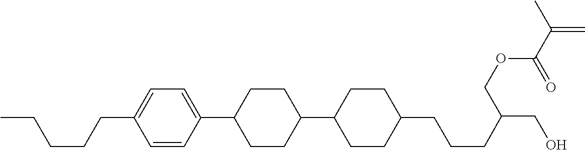 [SMILES: C=C(C)C(=O)OCC(CO)CCCC1CCC(C2CCC(c3ccc(CCCCC)cc3)CC2)CC1] |
| 1ϵ-7-41 | 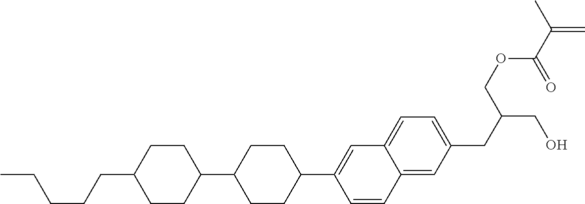 [SMILES: C=C(C)C(=O)OCC(CO)Cc1ccc2cc(C3CCC(C4CCC(CCCCC)CC4)CC3)ccc2c1] |
| 1ϵ-7-42 | 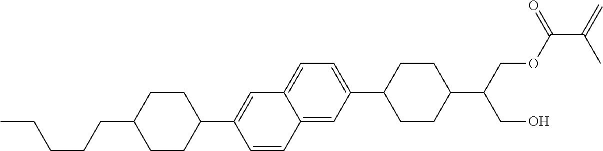 [SMILES: C=C(C)C(=O)OCC(CO)C1CCC(c2ccc3cc(C4CCC(CCCCC)CC4)ccc3c2)CC1] |
| 1ϵ-7-43 | 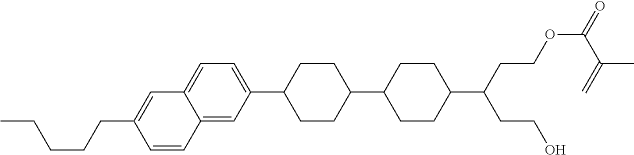 [SMILES: C=C(C)C(=O)OCCC(CCO)C1CCC(C2CCC(c3ccc4cc(CCCCC)ccc4c3)CC2)CC1] |
| 1ϵ-7-44 | 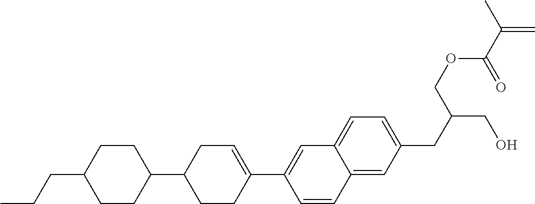 [SMILES: C=C(C)C(=O)OCC(CO)Cc1ccc2cc(C3=CCC(C4CCC(CCC)CC4)CC3)ccc2c1] |
| 1ϵ-7-45 | 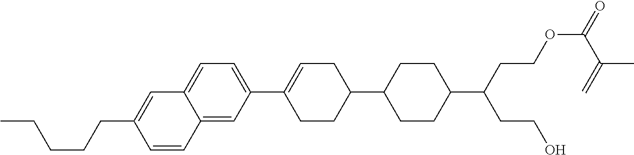 [SMILES: C=C(C)C(=O)OCCC(CCO)C1CCC(C2CC=C(c3ccc4cc(CCCCC)ccc4c3)CC2)CC1] |
| 1ϵ-7-46 | 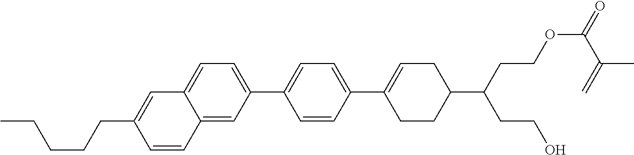 [SMILES: C=C(C)C(=O)OCCC(CCO)C1CC=C(c2ccc(-c3ccc4cc(CCCCC)ccc4c3)cc2)CC1] |
| 1ϵ-7-47 | 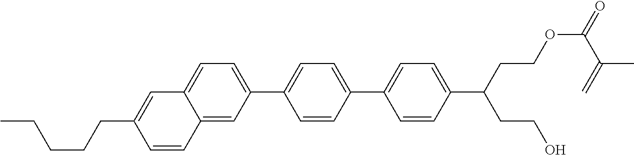 [SMILES: C=C(C)C(=O)OCCC(CCO)c1ccc(-c2ccc(-c3ccc4cc(CCCCC)ccc4c3)cc2)cc1] |
| 1ϵ-7-48 | 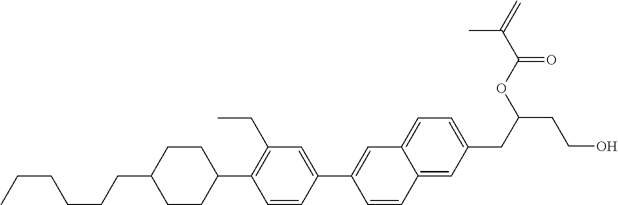 [SMILES: C=C(C)C(=O)OC(CCO)Cc1ccc2cc(-c3ccc(C4CCC(CCCCCC)CC4)c(CC)c3)ccc2c1] |
| 1ϵ-7-49 | 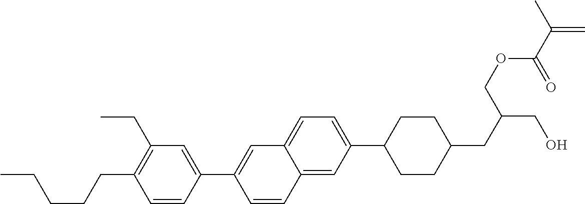 [SMILES: C=C(C)C(=O)OCC(CO)CC1CCC(c2ccc3cc(-c4ccc(CCCCC)c(CC)c4)ccc3c2)CC1] |
| 1ϵ-7-50 | 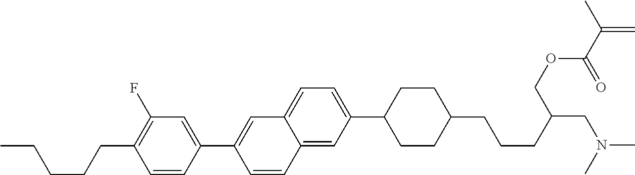 [SMILES: C=C(C)C(=O)OCC(CCCC1CCC(c2ccc3cc(-c4ccc(CCCCC)c(F)c4)ccc3c2)CC1)CN(C)C] |
| 1ϵ-7-51 | 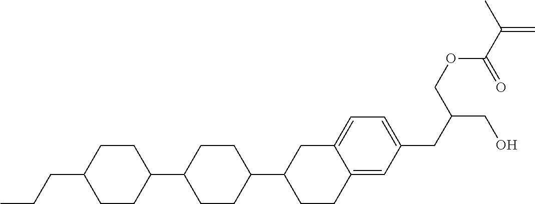 [SMILES: C=C(C)C(=O)OCC(CO)Cc1ccc2c(c1)CCC(C1CCC(C3CCC(CCC)CC3)CC1)C2] |
| 1ϵ-7-52 | 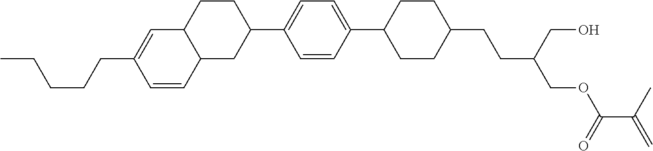 [SMILES: C=C(C)C(=O)OCC(CO)CCC1CCC(c2ccc(C3CCC4C=C(CCCCC)C=CC4C3)cc2)CC1] |
| 1ϵ-7-53 | 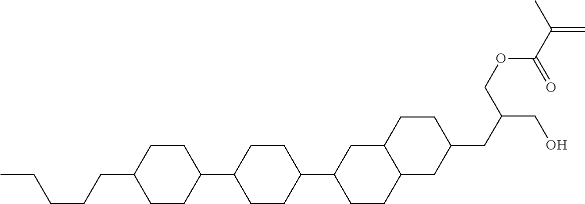 [SMILES: C=C(C)C(=O)OCC(CO)CC1CCC2CC(C3CCC(C4CCC(CCCCC)CC4)CC3)CCC2C1] |
| 1ϵ-7-54 | 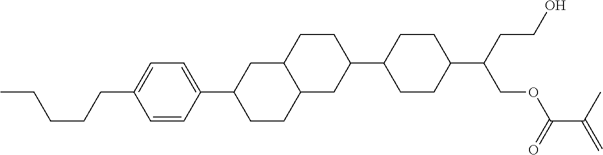 [SMILES: C=C(C)C(=O)OCC(CCO)C1CCC(C2CCC3CC(c4ccc(CCCCC)cc4)CCC3C2)CC1] |
| 1ϵ-7-55 | 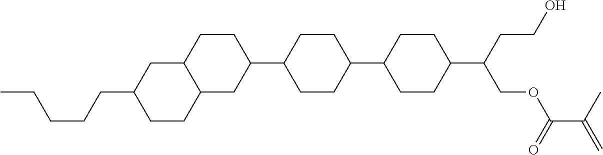 [SMILES: C=C(C)C(=O)OCC(CCO)C1CCC(C2CCC(C3CCC4CC(CCCCC)CCC4C3)CC2)CC1] |
| 1ϵ-7-56 | 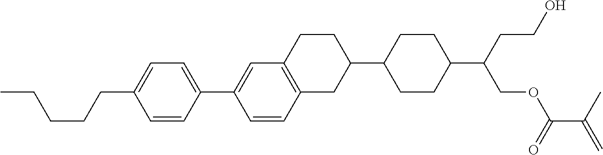 [SMILES: C=C(C)C(=O)OCC(CCO)C1CCC(C2CCc3cc(-c4ccc(CCCCC)cc4)ccc3C2)CC1] |
| 1ϵ-7-57 | 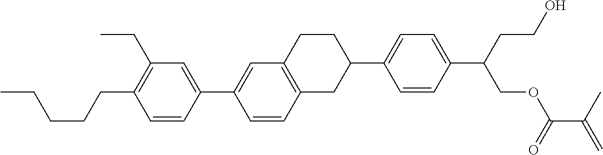 [SMILES: C=C(C)C(=O)OCC(CCO)c1ccc(C2CCc3cc(-c4ccc(CCCCC)c(CC)c4)ccc3C2)cc1] |
| 1ϵ-7-58 | 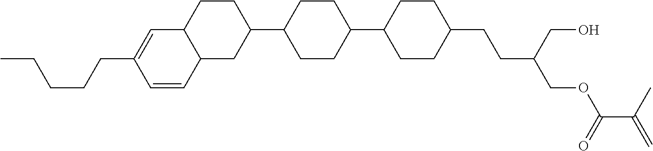 [SMILES: C=C(C)C(=O)OCC(CO)CCC1CCC(C2CCC(C3CCC4C=C(CCCCC)C=CC4C3)CC2)CC1] |
| 1ϵ-7-59 | 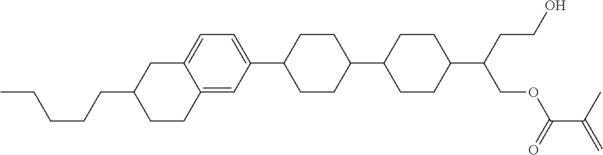 [SMILES: C=C(C)C(=O)OCC(CCO)C1CCC(C2CCC(c3ccc4c(c3)CCC(CCCCC)C4)CC2)CC1] |
| 1ϵ-7-60 | 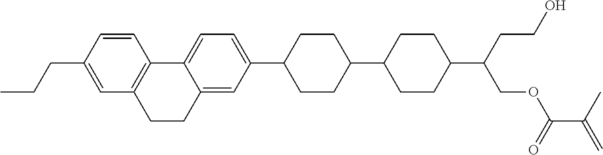 [SMILES: C=C(C)C(=O)OCC(CCO)C1CCC(C2CCC(c3ccc4c(c3)CCc3cc(CCC)ccc3-4)CC2)CC1] |
| 1ϵ-7-61 | 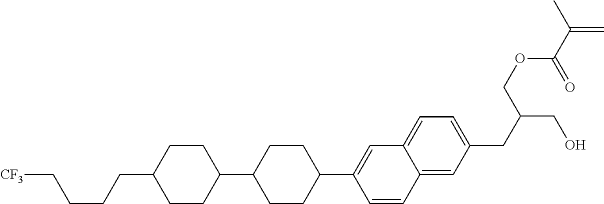 [SMILES: C=C(C)C(=O)OCC(CO)Cc1ccc2cc(C3CCC(C4CCC(CCCCC(F)(F)F)CC4)CC3)ccc2c1] |
| 1ϵ-7-62 | 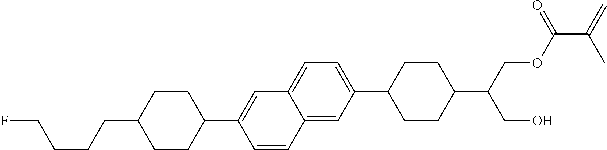 [SMILES: C=C(C)C(=O)OCC(CO)C1CCC(c2ccc3cc(C4CCC(CCCCF)CC4)ccc3c2)CC1] |
| 1ϵ-7-63 | 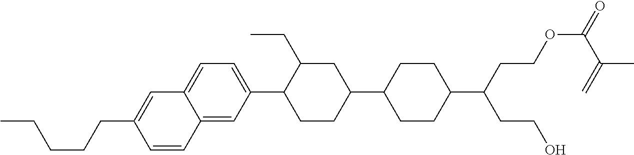 [SMILES: C=C(C)C(=O)OCCC(CCO)C1CCC(C2CCC(c3ccc4cc(CCCCC)ccc4c3)C(CC)C2)CC1] |
| 1ϵ-7-64 | 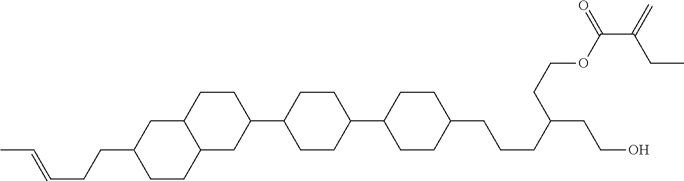 [SMILES: C=C(CC)C(=O)OCCC(CCO)CCCC1CCC(C2CCC(C3CCC4CC(CC/C=C/C)CCC4C3)CC2)CC1] |
| 1ϵ-7-65 | 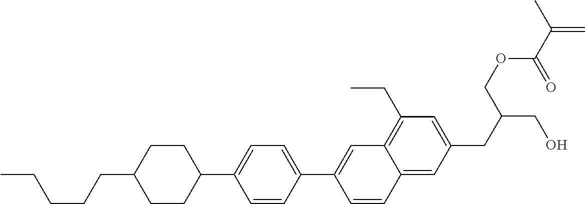 [SMILES: C=C(C)C(=O)OCC(CO)Cc1cc(CC)c2cc(-c3ccc(C4CCC(CCCCC)CC4)cc3)ccc2c1] |
| 1ϵ-7-66 | 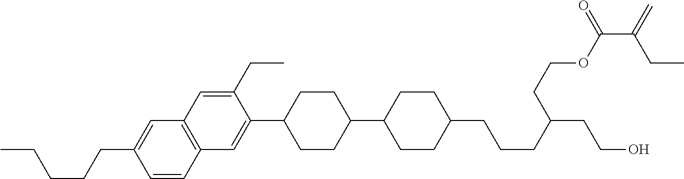 [SMILES: C=C(CC)C(=O)OCCC(CCO)CCCC1CCC(C2CCC(c3cc4ccc(CCCCC)cc4cc3CC)CC2)CC1] |
| 1ϵ-7-67 | 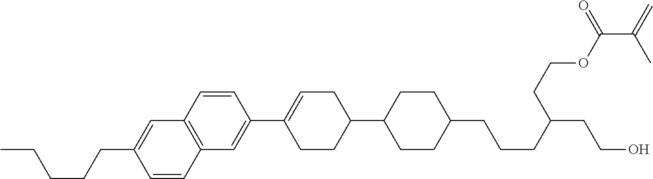 [SMILES: C=C(C)C(=O)OCCC(CCO)CCCC1CCC(C2CC=C(c3ccc4cc(CCCCC)ccc4c3)CC2)CC1] |
| 1ϵ-7-68 | 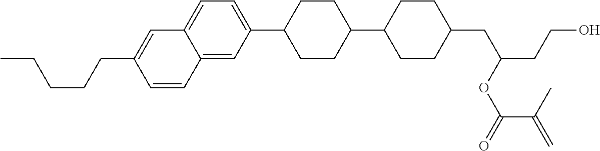 [SMILES: C=C(C)C(=O)OC(CCO)CC1CCC(C2CCC(c3ccc4cc(CCCCC)ccc4c3)CC2)CC1] |
| 1ϵ-7-69 | 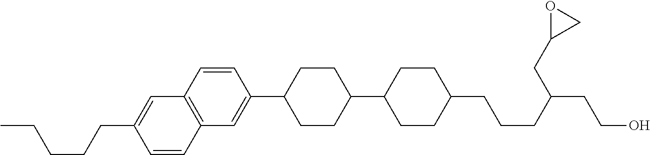 [SMILES: CCCCCc1ccc2cc(C3CCC(C4CCC(CCCC(CCO)CC5CO5)CC4)CC3)ccc2c1] |
| 1ϵ-7-70 | 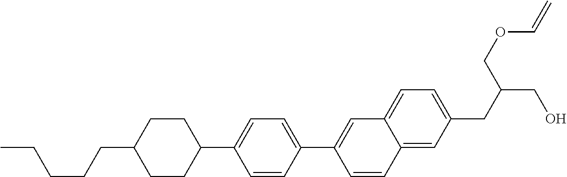 [SMILES: C=COCC(CO)Cc1ccc2cc(-c3ccc(C4CCC(CCCCC)CC4)cc3)ccc2c1] |
| 1ϵ-7-71 | 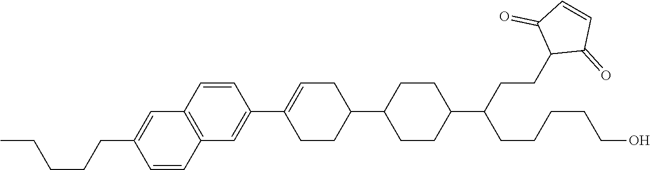 [SMILES: CCCCCc1ccc2cc(C3=CCC(C4CCC(C(CCCCCO)CCC5C(=O)C=CC5=O)CC4)CC3)ccc2c1] |
| 1ϵ-7-72 | 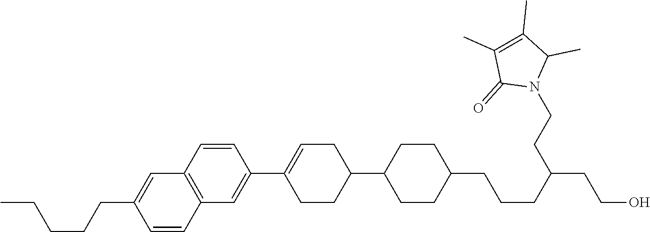 [SMILES: CCCCCc1ccc2cc(C3=CCC(C4CCC(CCCC(CCO)CCN5C(=O)C(C)=C(C)C5C)CC4)CC3)ccc2c1] |
| 1ϵ-7-73 | 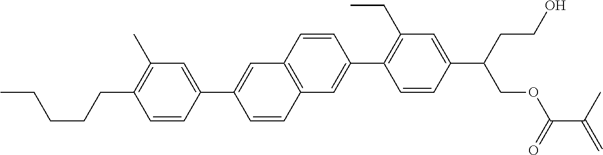 [SMILES: C=C(C)C(=O)OCC(CCO)c1ccc(-c2ccc3cc(-c4ccc(CCCCC)c(C)c4)ccc3c2)c(CC)c1] |
| 1ϵ-7-74 | 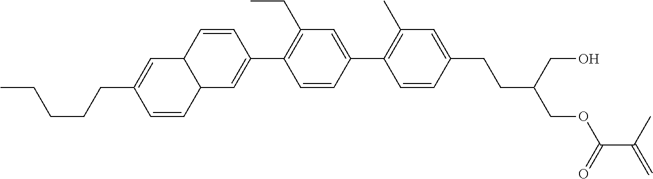 [SMILES: C=C(C)C(=O)OCC(CO)CCc1ccc(-c2ccc(C3=CC4C=CC(CCCCC)=CC4C=C3)c(CC)c2)c(C)c1] |
| 1ϵ-7-75 | 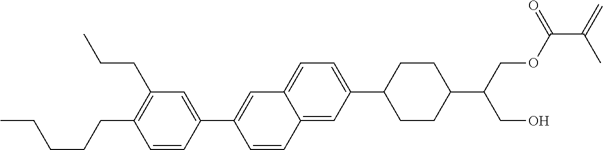 [SMILES: C=C(C)C(=O)OCC(CO)C1CCC(c2ccc3cc(-c4ccc(CCCCC)c(CCC)c4)ccc3c2)CC1] |
| 1ϵ-7-76 | 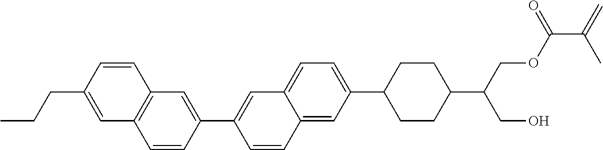 [SMILES: C=C(C)C(=O)OCC(CO)C1CCC(c2ccc3cc(-c4ccc5cc(CCC)ccc5c4)ccc3c2)CC1] |
| 1ϵ-7-77 | 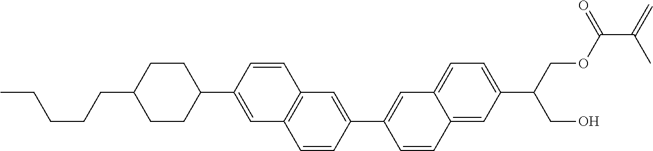 [SMILES: C=C(C)C(=O)OCC(CO)c1ccc2cc(-c3ccc4cc(C5CCC(CCCCC)CC5)ccc4c3)ccc2c1] |
| 1ϵ-7-78 | 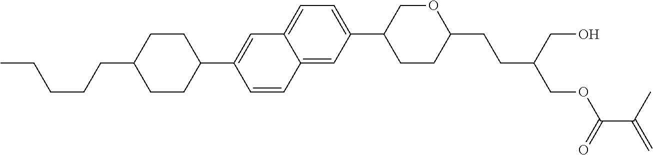 [SMILES: C=C(C)C(=O)OCC(CO)CCC1CCC(c2ccc3cc(C4CCC(CCCCC)CC4)ccc3c2)CO1] |
| 1ϵ-7-79 | 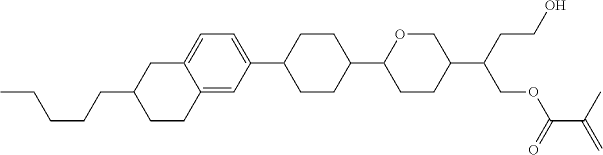 [SMILES: C=C(C)C(=O)OCC(CCO)C1CCC(C2CCC(c3ccc4c(c3)CCC(CCCCC)C4)CC2)OC1] |
| 1ϵ-7-80 | 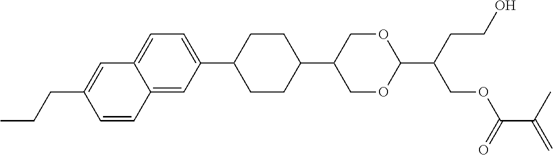 [SMILES: C=C(C)C(=O)OCC(CCO)C1OCC(C2CCC(c3ccc4cc(CCC)ccc4c3)CC2)CO1] |
| 1ϵ-7-81 | 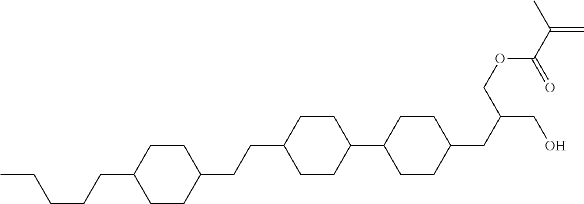 [SMILES: C=C(C)C(=O)OCC(CO)CC1CCC(C2CCC(CCC3CCC(CCCCC)CC3)CC2)CC1] |
| 1ϵ-7-82 | 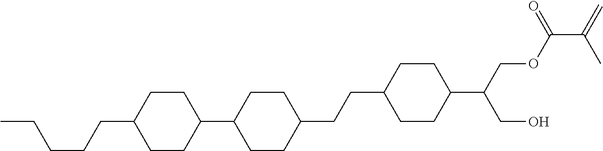 [SMILES: C=C(C)C(=O)OCC(CO)C1CCC(CCC2CCC(C3CCC(CCCCC)CC3)CC2)CC1] |
| 1ϵ-7-83 | 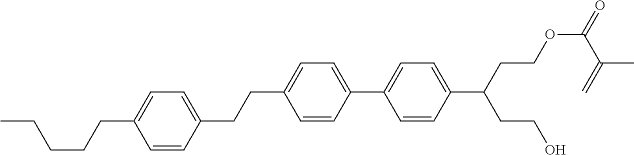 [SMILES: C=C(C)C(=O)OCCC(CCO)c1ccc(-c2ccc(CCc3ccc(CCCCC)cc3)cc2)cc1] |
| 1ϵ-7-84 | 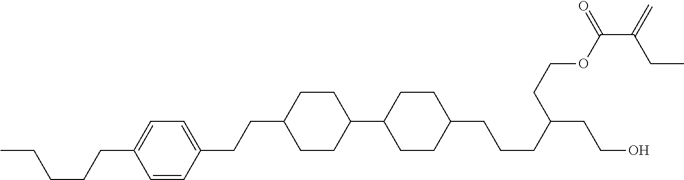 [SMILES: C=C(CC)C(=O)OCCC(CCO)CCCC1CCC(C2CCC(CCc3ccc(CCCCC)cc3)CC2)CC1] |
| 1ϵ-7-85 | 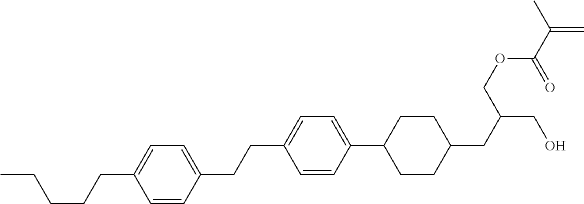 [SMILES: C=C(C)C(=O)OCC(CO)CC1CCC(c2ccc(CCc3ccc(CCCCC)cc3)cc2)CC1] |
| 1ϵ-7-86 | 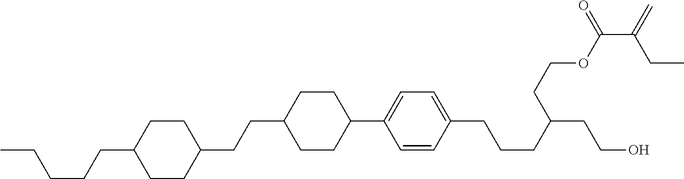 [SMILES: C=C(CC)C(=O)OCCC(CCO)CCCc1ccc(C2CCC(CCC3CCC(CCCCC)CC3)CC2)cc1] |
| 1ϵ-7-87 | 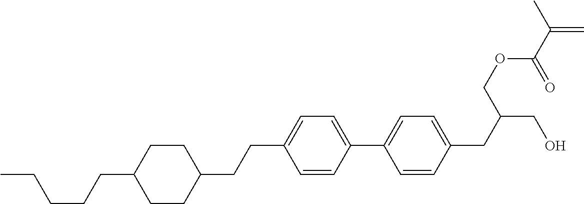 [SMILES: C=C(C)C(=O)OCC(CO)Cc1ccc(-c2ccc(CCC3CCC(CCCCC)CC3)cc2)cc1] |
| 1ϵ-7-88 | 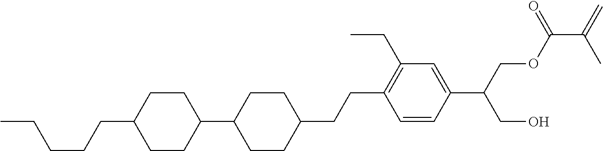 [SMILES: C=C(C)C(=O)OCC(CO)c1ccc(CCC2CCC(C3CCC(CCCCC)CC3)CC2)c(CC)c1] |
| 1ϵ-7-89 | 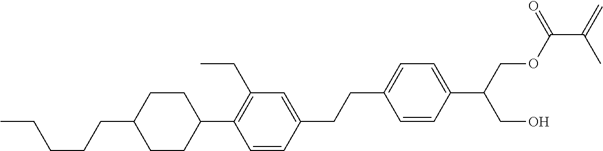 [SMILES: C=C(C)C(=O)OCC(CO)c1ccc(CCc2ccc(C3CCC(CCCCC)CC3)c(CC)c2)cc1] |
| 1ϵ-7-90 | 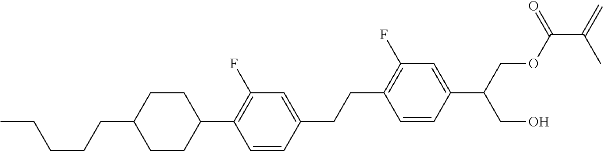 [SMILES: C=C(C)C(=O)OCC(CO)c1ccc(CCc2ccc(C3CCC(CCCCC)CC3)c(F)c2)c(F)c1] |
| 1ϵ-7-91 | 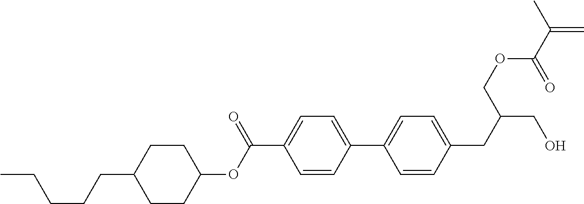 [SMILES: C=C(C)C(=O)OCC(CO)Cc1ccc(-c2ccc(C(=O)OC3CCC(CCCCC)CC3)cc2)cc1] |
| 1ϵ-7-92 | 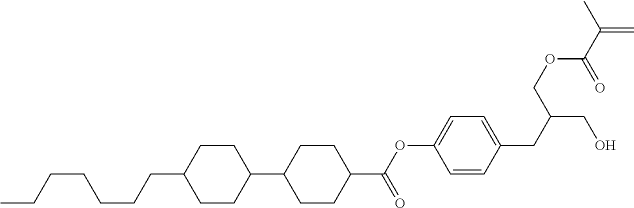 [SMILES: C=C(C)C(=O)OCC(CO)Cc1ccc(OC(=O)C2CCC(C3CCC(CCCCCCC)CC3)CC2)cc1] |
| 1ϵ-7-93 | 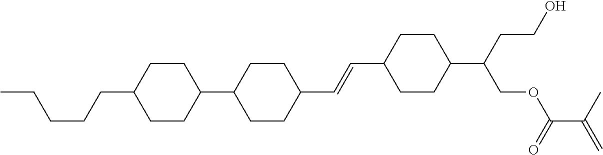 [SMILES: C=C(C)C(=O)OCC(CCO)C1CCC(/C=C/C2CCC(C3CCC(CCCCC)CC3)CC2)CC1] |
| 1ϵ-7-94 | 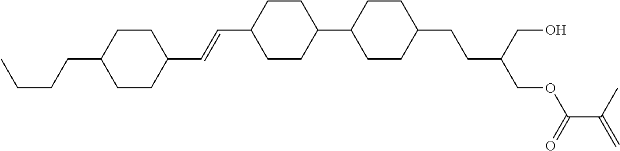 [SMILES: C=C(C)C(=O)OCC(CO)CCC1CCC(C2CCC(/C=C/C3CCC(CCCC)CC3)CC2)CC1] |
| 1ϵ-7-95 | 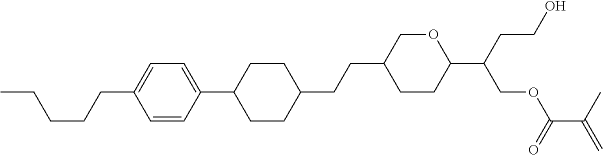 [SMILES: C=C(C)C(=O)OCC(CCO)C1CCC(CCC2CCC(c3ccc(CCCCC)cc3)CC2)CO1] |
| 1ϵ-7-96 | 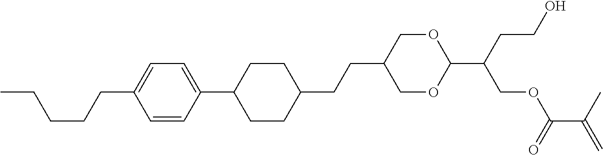 [SMILES: C=C(C)C(=O)OCC(CCO)C1OCC(CCC2CCC(c3ccc(CCCCC)cc3)CC2)CO1] |
| 1ϵ-7-97 | 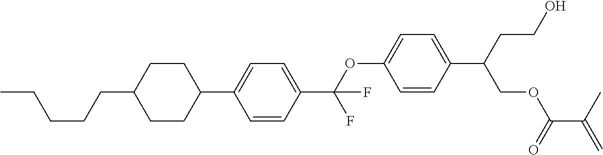 [SMILES: C=C(C)C(=O)OCC(CCO)c1ccc(OC(F)(F)c2ccc(C3CCC(CCCCC)CC3)cc2)cc1] |
| 1ϵ-7-98 | 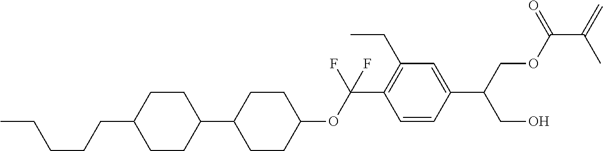 [SMILES: C=C(C)C(=O)OCC(CO)c1ccc(C(F)(F)OC2CCC(C3CCC(CCCCC)CC3)CC2)c(CC)c1] |
| 1ϵ-7-99 | 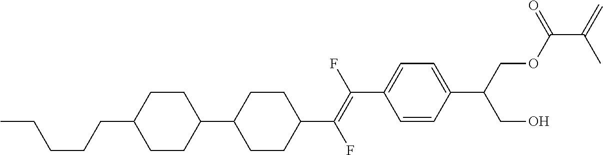 [SMILES: C=C(C)C(=O)OCC(CO)c1ccc(/C(F)=C(\F)C2CCC(C3CCC(CCCCC)CC3)CC2)cc1] |
| 1ϵ-7-100 | 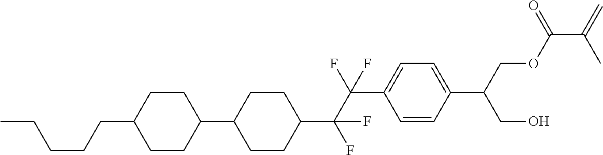 [SMILES: C=C(C)C(=O)OCC(CO)c1ccc(C(F)(F)C(F)(F)C2CCC(C3CCC(CCCCC)CC3)CC2)cc1] |
| 1ϵ-7-101 | 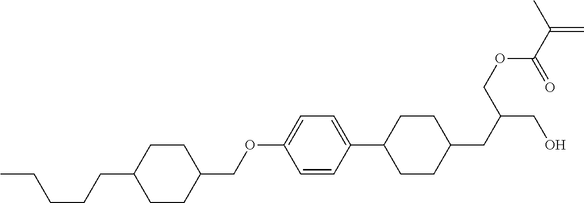 [SMILES: C=C(C)C(=O)OCC(CO)CC1CCC(c2ccc(OCC3CCC(CCCCC)CC3)cc2)CC1] |
| 1ϵ-7-102 | 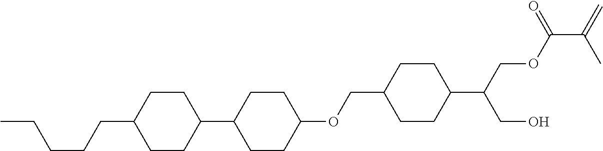 [SMILES: C=C(C)C(=O)OCC(CO)C1CCC(COC2CCC(C3CCC(CCCCC)CC3)CC2)CC1] |
| 1ϵ-7-103 | 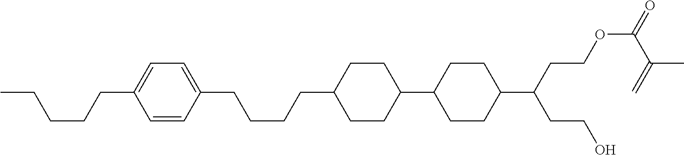 [SMILES: C=C(C)C(=O)OCCC(CCO)C1CCC(C2CCC(CCCCc3ccc(CCCCC)cc3)CC2)CC1] |
| 1ϵ-7-104 | 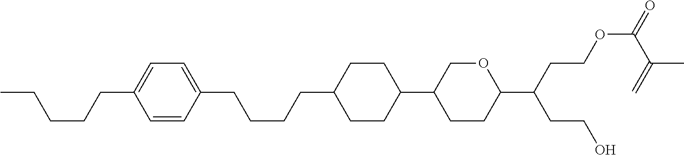 [SMILES: C=C(C)C(=O)OCCC(CCO)C1CCC(C2CCC(CCCCc3ccc(CCCCC)cc3)CC2)CO1] |
| 1ϵ-7-105 | 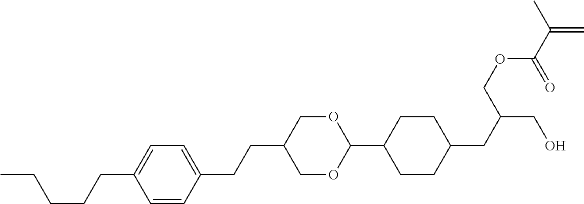 [SMILES: C=C(C)C(=O)OCC(CO)CC1CCC(C2OCC(CCc3ccc(CCCCC)cc3)CO2)CC1] |
| 1ϵ-7-106 | 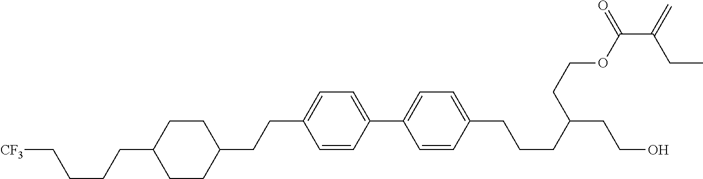 [SMILES: C=C(CC)C(=O)OCCC(CCO)CCCc1ccc(-c2ccc(CCC3CCC(CCCCC(F)(F)F)CC3)cc2)cc1] |
| 1ϵ-7-107 | 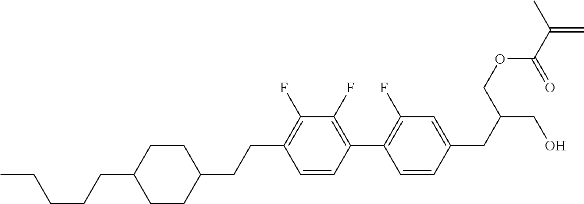 [SMILES: C=C(C)C(=O)OCC(CO)Cc1ccc(-c2ccc(CCC3CCC(CCCCC)CC3)c(F)c2F)c(F)c1] |
| 1ϵ-7-108 | 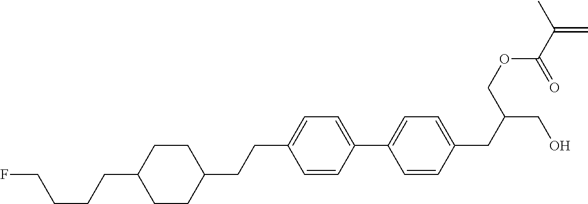 [SMILES: C=C(C)C(=O)OCC(CO)Cc1ccc(-c2ccc(CCC3CCC(CCCCF)CC3)cc2)cc1] |
| 1ϵ-7-109 | 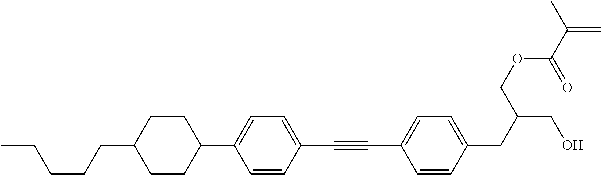 [SMILES: C=C(C)C(=O)OCC(CO)Cc1ccc(C#Cc2ccc(C3CCC(CCCCC)CC3)cc2)cc1] |
| 1ϵ-7-110 | 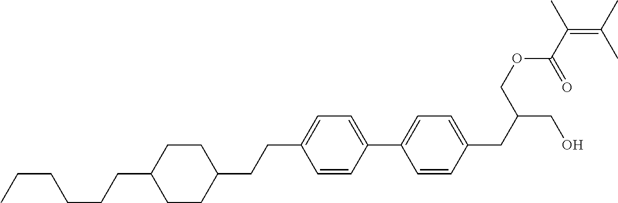 [SMILES: CCCCCCC1CCC(CCc2ccc(-c3ccc(CC(CO)COC(=O)C(C)=C(C)C)cc3)cc2)CC1] |
| 1ϵ-7-111 | 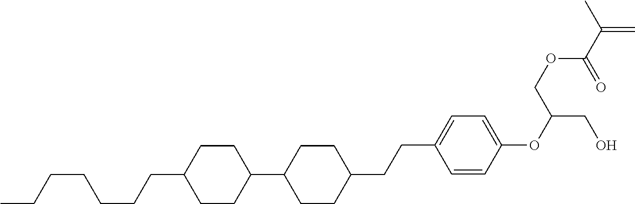 [SMILES: C=C(C)C(=O)OCC(CO)Oc1ccc(CCC2CCC(C3CCC(CCCCCCC)CC3)CC2)cc1] |
| 1ϵ-7-112 | 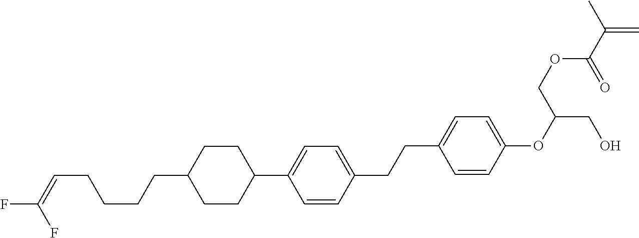 [SMILES: C=C(C)C(=O)OCC(CO)Oc1ccc(CCc2ccc(C3CCC(CCCCC=C(F)F)CC3)cc2)cc1] |
| 1ϵ-7-113 | 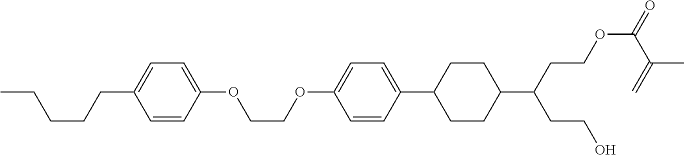 [SMILES: C=C(C)C(=O)OCCC(CCO)C1CCC(c2ccc(OCCOc3ccc(CCCCC)cc3)cc2)CC1] |
| 1ϵ-7-114 | 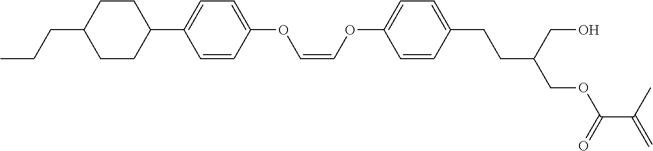 [SMILES: C=C(C)C(=O)OCC(CO)CCc1ccc(O/C=C\Oc2ccc(C3CCC(CCC)CC3)cc2)cc1] |
| 1ϵ-7-115 | 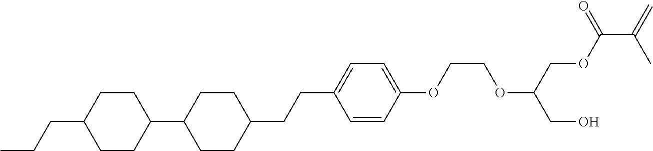 [SMILES: C=C(C)C(=O)OCC(CO)OCCOc1ccc(CCC2CCC(C3CCC(CCC)CC3)CC2)cc1] |
| 1ϵ-7-116 | 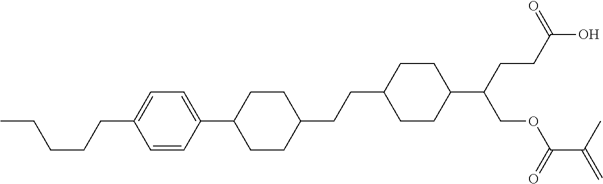 [SMILES: C=C(C)C(=O)OCC(CCC(=O)O)C1CCC(CCC2CCC(c3ccc(CCCCC)cc3)CC2)CC1] |
| 1ϵ-7-117 | 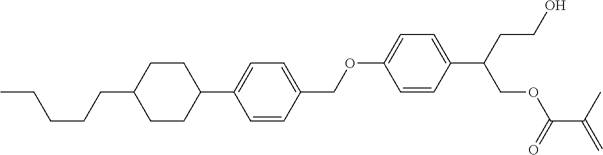 [SMILES: C=C(C)C(=O)OCC(CCO)c1ccc(OCc2ccc(C3CCC(CCCCC)CC3)cc2)cc1] |
| 1ϵ-7-118 | 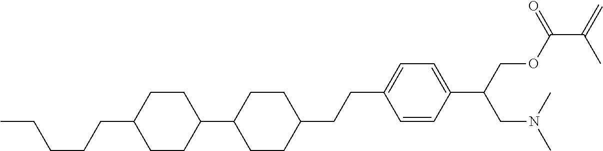 [SMILES: C=C(C)C(=O)OCC(CN(C)C)c1ccc(CCC2CCC(C3CCC(CCCCC)CC3)CC2)cc1] |
| 1ϵ-7-119 | 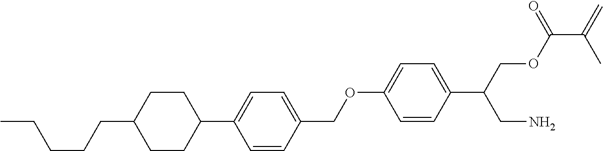 [SMILES: C=C(C)C(=O)OCC(CN)c1ccc(OCc2ccc(C3CCC(CCCCC)CC3)cc2)cc1] |
| 1ϵ-7-120 | 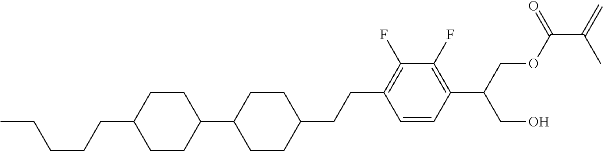 [SMILES: C=C(C)C(=O)OCC(CO)c1ccc(CCC2CCC(C3CCC(CCCCC)CC3)CC2)c(F)c1F] |
| 1ϵ-7-121 | 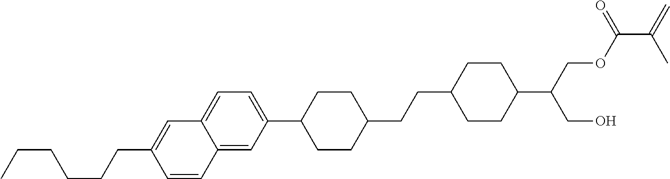 [SMILES: C=C(C)C(=O)OCC(CO)C1CCC(CCC2CCC(c3ccc4cc(CCCCCC)ccc4c3)CC2)CC1] |
| 1ϵ-7-122 | 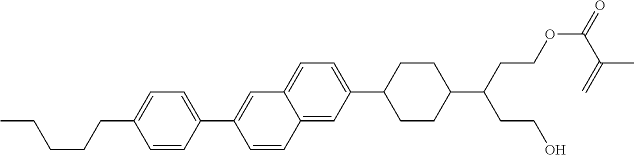 [SMILES: C=C(C)C(=O)OCCC(CCO)C1CCC(c2ccc3cc(-c4ccc(CCCCC)cc4)ccc3c2)CC1] |
| 1ϵ-7-123 | 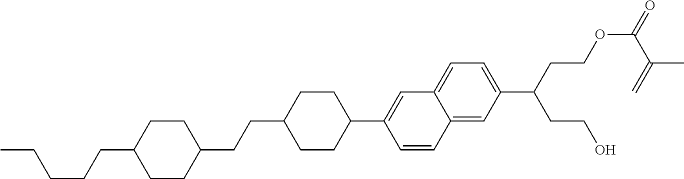 [SMILES: C=C(C)C(=O)OCCC(CCO)c1ccc2cc(C3CCC(CCC4CCC(CCCCC)CC4)CC3)ccc2c1] |
| 1ϵ-7-124 | 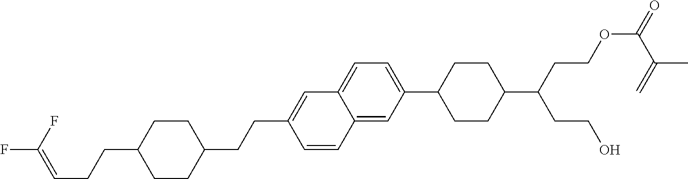 [SMILES: C=C(C)C(=O)OCCC(CCO)C1CCC(c2ccc3cc(CCC4CCC(CCC=C(F)F)CC4)ccc3c2)CC1] |
| 1ϵ-7-125 | 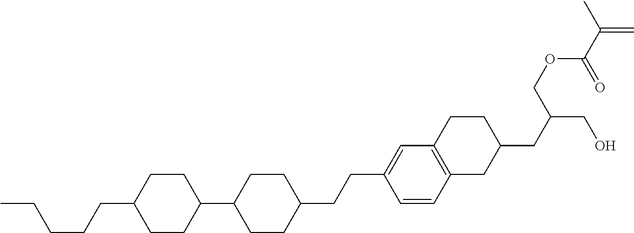 [SMILES: C=C(C)C(=O)OCC(CO)CC1CCc2cc(CCC3CCC(C4CCC(CCCCC)CC4)CC3)ccc2C1] |
| 1ϵ-7-126 | 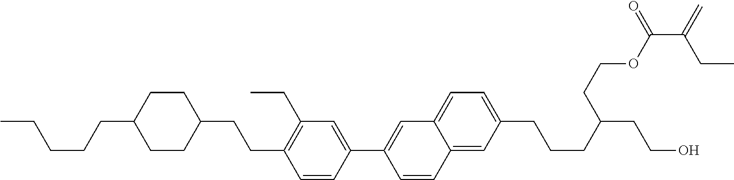 [SMILES: C=C(CC)C(=O)OCCC(CCO)CCCc1ccc2cc(-c3ccc(CCC4CCC(CCCCC)CC4)c(CC)c3)ccc2c1] |
| 1ϵ-7-127 | 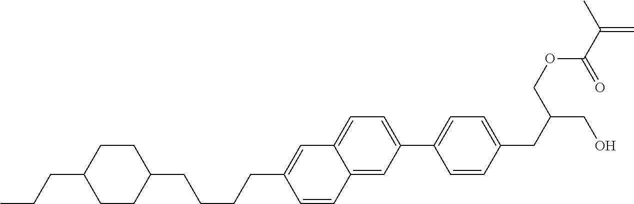 [SMILES: C=C(C)C(=O)OCC(CO)Cc1ccc(-c2ccc3cc(CCCCC4CCC(CCC)CC4)ccc3c2)cc1] |
| 1ϵ-7-128 | 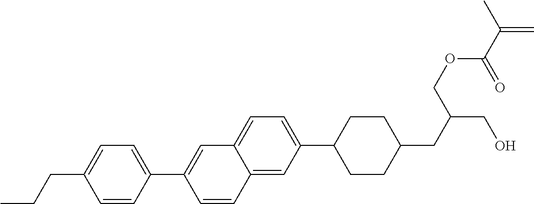 [SMILES: C=C(C)C(=O)OCC(CO)CC1CCC(c2ccc3cc(-c4ccc(CCC)cc4)ccc3c2)CC1] |
| 1ϵ-7-129 | 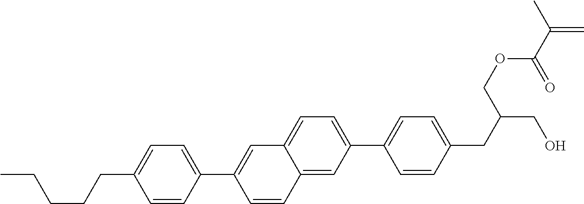 [SMILES: C=C(C)C(=O)OCC(CO)Cc1ccc(-c2ccc3cc(-c4ccc(CCCCC)cc4)ccc3c2)cc1] |
| 1ϵ-7-130 | 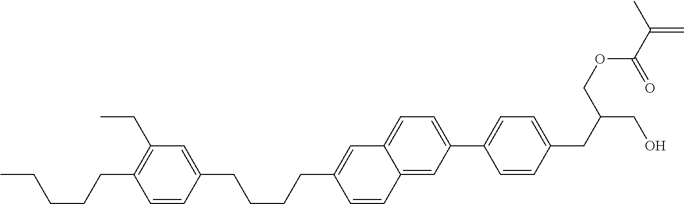 [SMILES: C=C(C)C(=O)OCC(CO)Cc1ccc(-c2ccc3cc(CCCCc4ccc(CCCCC)c(CC)c4)ccc3c2)cc1] |
| 1ϵ-7-131 | 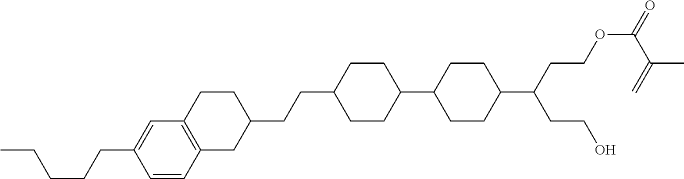 [SMILES: C=C(C)C(=O)OCCC(CCO)C1CCC(C2CCC(CCC3CCc4cc(CCCCC)ccc4C3)CC2)CC1] |
| 1ϵ-7-132 | 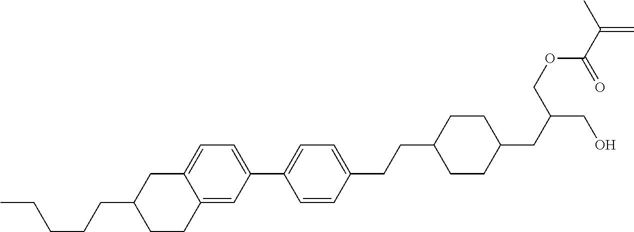 [SMILES: C=C(C)C(=O)OCC(CO)CC1CCC(CCc2ccc(-c3ccc4c(c3)CCC(CCCCC)C4)cc2)CC1] |
| 1ϵ-7-133 | 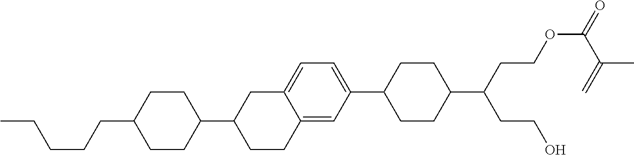 [SMILES: C=C(C)C(=O)OCCC(CCO)C1CCC(c2ccc3c(c2)CCC(C2CCC(CCCCC)CC2)C3)CC1] |
| 1ϵ-7-134 | 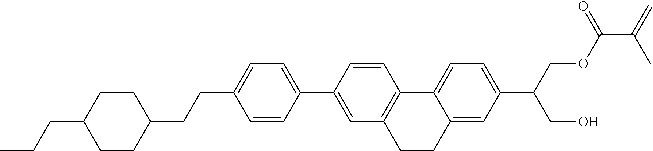 [SMILES: C=C(C)C(=O)OCC(CO)c1ccc2c(c1)CCc1cc(-c3ccc(CCC4CCC(CCC)CC4)cc3)ccc1-2] |
| 1ϵ-7-135 | 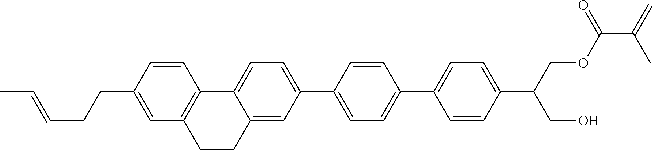 [SMILES: C=C(C)C(=O)OCC(CO)c1ccc(-c2ccc(-c3ccc4c(c3)CCc3cc(CC/C=C/C)ccc3-4)cc2)cc1] |
| 1ϵ-7-136 | 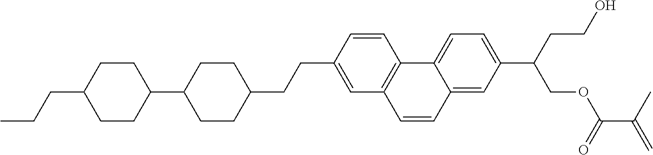 [SMILES: C=C(C)C(=O)OCC(CCO)c1ccc2c(ccc3cc(CCC4CCC(C5CCC(CCC)CC5)CC4)ccc32)c1] |
| 1ϵ-7-137 | 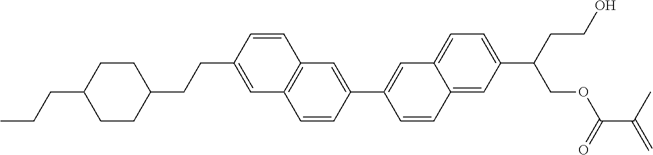 [SMILES: C=C(C)C(=O)OCC(CCO)c1ccc2cc(-c3ccc4cc(CCC5CCC(CCC)CC5)ccc4c3)ccc2c1] |
| 1ϵ-7-138 | 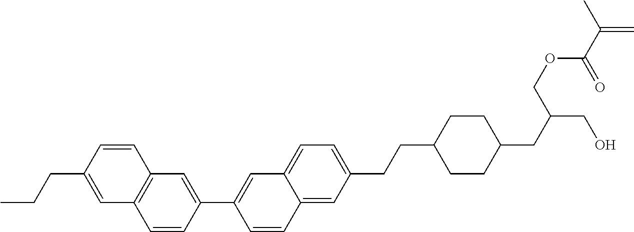 [SMILES: C=C(C)C(=O)OCC(CO)CC1CCC(CCc2ccc3cc(-c4ccc5cc(CCC)ccc5c4)ccc3c2)CC1] |
| 1ϵ-7-139 | 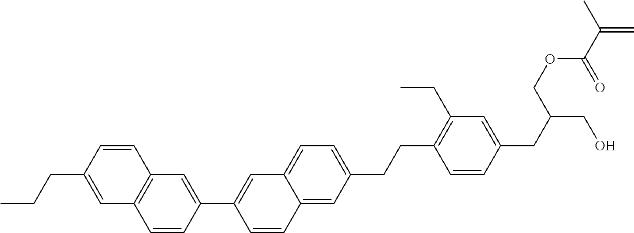 [SMILES: C=C(C)C(=O)OCC(CO)Cc1ccc(CCc2ccc3cc(-c4ccc5cc(CCC)ccc5c4)ccc3c2)c(CC)c1] |
| 1ϵ-7-140 | 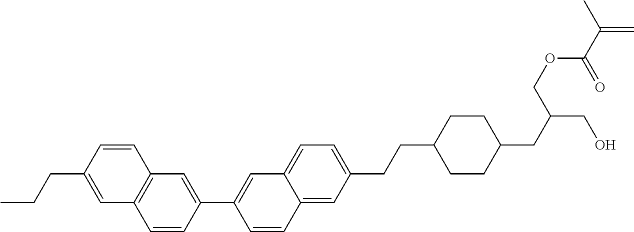 [SMILES: C=C(C)C(=O)OCC(CO)CC1CCC(CCc2ccc3cc(-c4ccc5cc(CCC)ccc5c4)ccc3c2)CC1] |
| 1ϵ-8-1 | 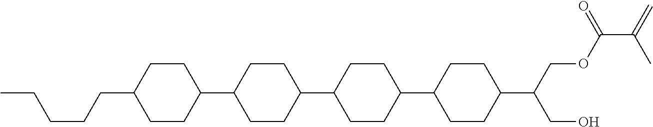 [SMILES: C=C(C)C(=O)OCC(CO)C1CCC(C2CCC(C3CCC(C4CCC(CCCCC)CC4)CC3)CC2)CC1] |
| 1ϵ-8-2 | 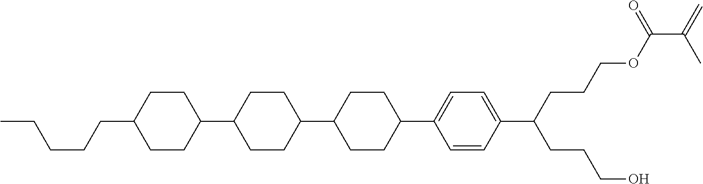 [SMILES: C=C(C)C(=O)OCCCC(CCCO)c1ccc(C2CCC(C3CCC(C4CCC(CCCCC)CC4)CC3)CC2)cc1] |
| 1ϵ-8-3 | 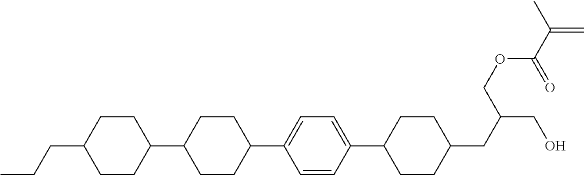 [SMILES: C=C(C)C(=O)OCC(CO)CC1CCC(c2ccc(C3CCC(C4CCC(CCC)CC4)CC3)cc2)CC1] |
| 1ϵ-8-4 | 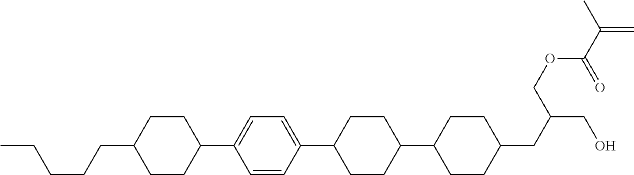 [SMILES: C=C(C)C(=O)OCC(CO)CC1CCC(C2CCC(c3ccc(C4CCC(CCCCC)CC4)cc3)CC2)CC1] |
| 1ϵ-8-5 | 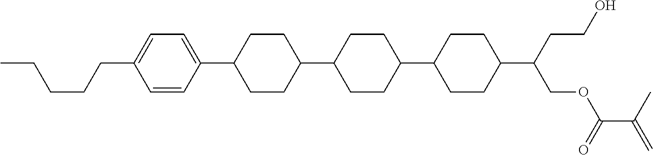 [SMILES: C=C(C)C(=O)OCC(CCO)C1CCC(C2CCC(C3CCC(c4ccc(CCCCC)cc4)CC3)CC2)CC1] |
| 1ϵ-8-6 | 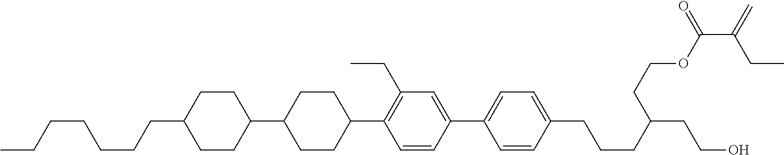 [SMILES: C=C(CC)C(=O)OCCC(CCO)CCCc1ccc(-c2ccc(C3CCC(C4CCC(CCCCCCC)CC4)CC3)c(CC)c2)cc1] |
| 1ϵ-8-7 | 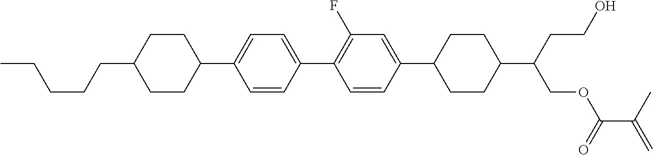 [SMILES: C=C(C)C(=O)OCC(CCO)C1CCC(c2ccc(-c3ccc(C4CCC(CCCCC)CC4)cc3)c(F)c2)CC1] |
| 1ϵ-8-8 | 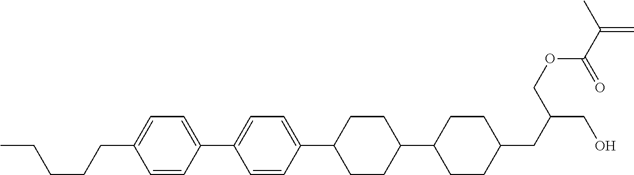 [SMILES: C=C(C)C(=O)OCC(CO)CC1CCC(C2CCC(c3ccc(-c4ccc(CCCCC)cc4)cc3)CC2)CC1] |
| 1ϵ-8-9 | 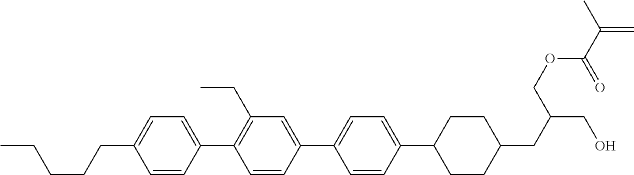 [SMILES: C=C(C)C(=O)OCC(CO)CC1CCC(c2ccc(-c3ccc(-c4ccc(CCCCC)cc4)c(CC)c3)cc2)CC1] |
| 1ϵ-8-10 | 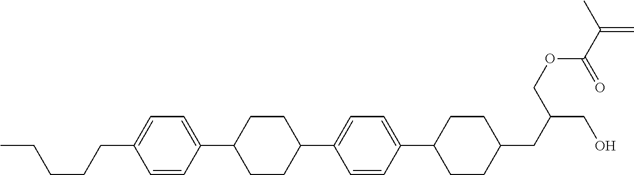 [SMILES: C=C(C)C(=O)OCC(CO)CC1CCC(c2ccc(C3CCC(c4ccc(CCCCC)cc4)CC3)cc2)CC1] |
| 1ϵ-8-11 | 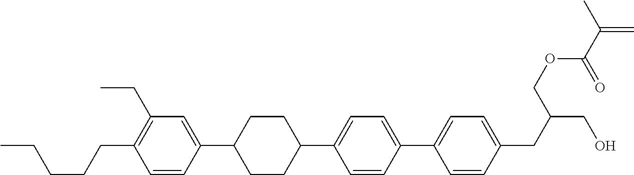 [SMILES: C=C(C)C(=O)OCC(CO)Cc1ccc(-c2ccc(C3CCC(c4ccc(CCCCC)c(CC)c4)CC3)cc2)cc1] |
| 1ϵ-8-12 | 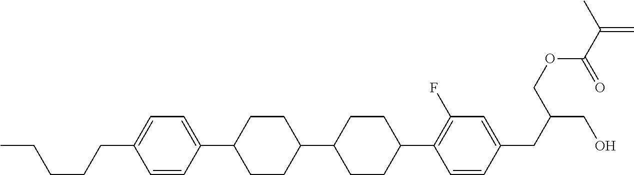 [SMILES: C=C(C)C(=O)OCC(CO)Cc1ccc(C2CCC(C3CCC(c4ccc(CCCCC)cc4)CC3)CC2)c(F)c1] |
| 1ϵ-8-13 | 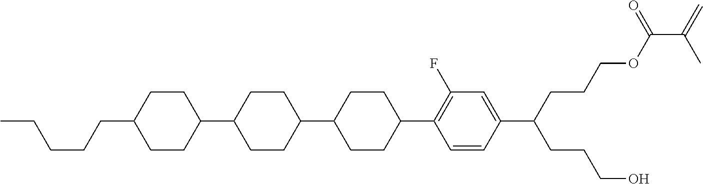 [SMILES: C=C(C)C(=O)OCCCC(CCCO)c1ccc(C2CCC(C3CCC(C4CCC(CCCCC)CC4)CC3)CC2)c(F)c1] |
| 1ϵ-8-14 | 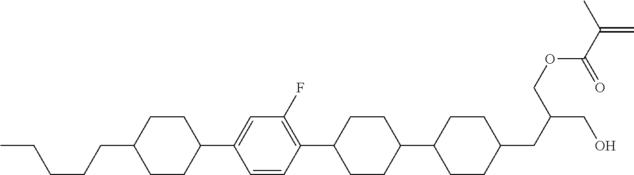 [SMILES: C=C(C)C(=O)OCC(CO)CC1CCC(C2CCC(c3ccc(C4CCC(CCCCC)CC4)cc3F)CC2)CC1] |
| 1ϵ-8-15 | 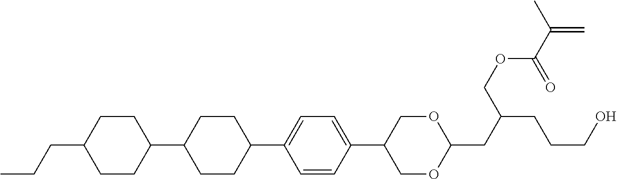 [SMILES: C=C(C)C(=O)OCC(CCCO)CC1OCC(c2ccc(C3CCC(C4CCC(CCC)CC4)CC3)cc2)CO1] |
| 1ϵ-8-16 | 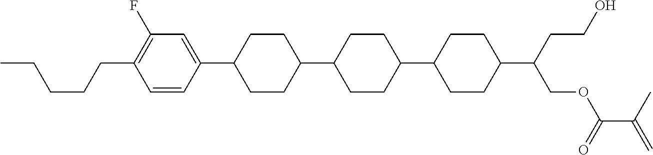 [SMILES: C=C(C)C(=O)OCC(CCO)C1CCC(C2CCC(C3CCC(c4ccc(CCCCC)c(F)c4)CC3)CC2)CC1] |
| 1ϵ-8-17 | 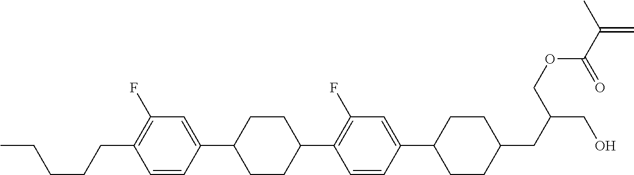 [SMILES: C=C(C)C(=O)OCC(CO)CC1CCC(c2ccc(C3CCC(c4ccc(CCCCC)c(F)c4)CC3)c(F)c2)CC1] |
| 1ϵ-8-18 | 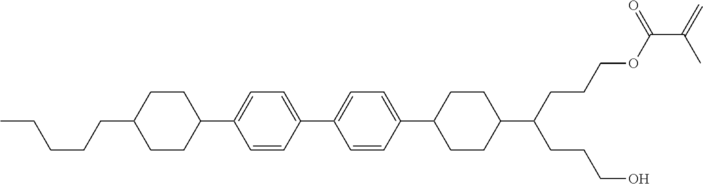 [SMILES: C=C(C)C(=O)OCCCC(CCCO)C1CCC(c2ccc(-c3ccc(C4CCC(CCCCC)CC4)cc3)cc2)CC1] |
| 1ϵ-8-19 | 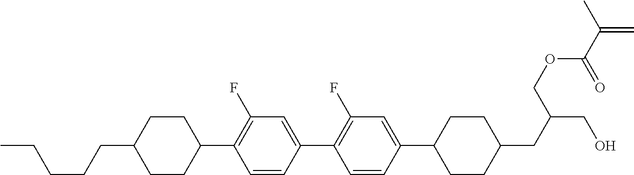 [SMILES: C=C(C)C(=O)OCC(CO)CC1CCC(c2ccc(-c3ccc(C4CCC(CCCCC)CC4)c(F)c3)c(F)c2)CC1] |
| 1ϵ-8-20 | 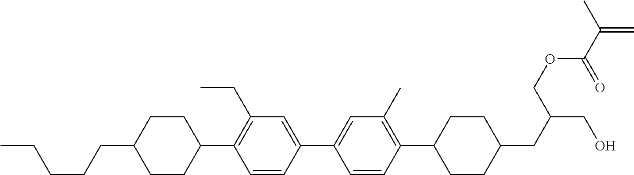 [SMILES: C=C(C)C(=O)OCC(CO)CC1CCC(c2ccc(-c3ccc(C4CCC(CCCCC)CC4)c(CC)c3)cc2C)CC1] |
| 1ϵ-8-21 | 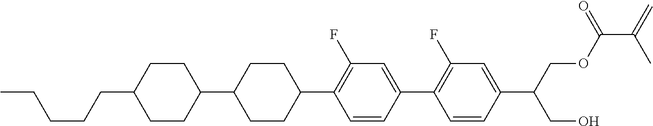 [SMILES: C=C(C)C(=O)OCC(CO)c1ccc(-c2ccc(C3CCC(C4CCC(CCCCC)CC4)CC3)c(F)c2)c(F)c1] |
| 1ϵ-8-22 | 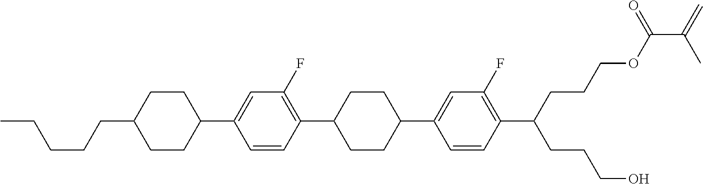 [SMILES: C=C(C)C(=O)OCCCC(CCCO)c1ccc(C2CCC(c3ccc(C4CCC(CCCCC)CC4)cc3F)CC2)cc1F] |
| 1ϵ-8-23 | 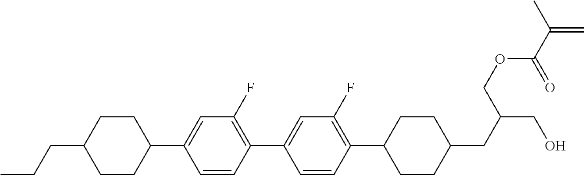 [SMILES: C=C(C)C(=O)OCC(CO)CC1CCC(c2ccc(-c3ccc(C4CCC(CCC)CC4)cc3F)cc2F)CC1] |
| 1ϵ-8-24 | 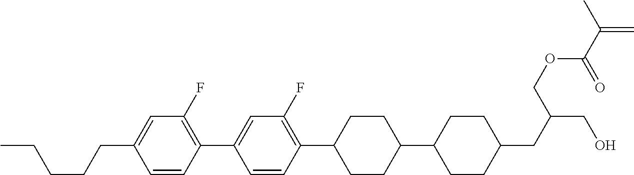 [SMILES: C=C(C)C(=O)OCC(CO)CC1CCC(C2CCC(c3ccc(-c4ccc(CCCCC)cc4F)cc3F)CC2)CC1] |
| 1ϵ-8-25 | 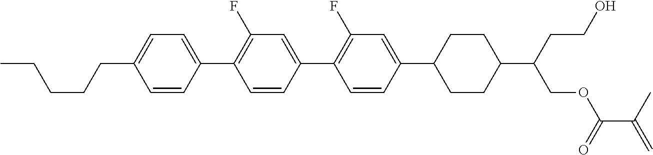 [SMILES: C=C(C)C(=O)OCC(CCO)C1CCC(c2ccc(-c3ccc(-c4ccc(CCCCC)cc4)c(F)c3)c(F)c2)CC1] |
| 1ϵ-8-26 | 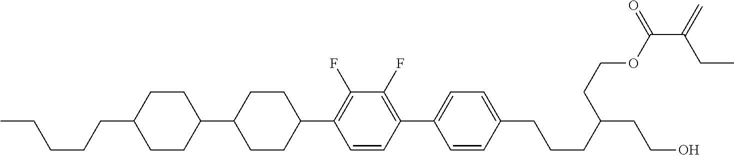 [SMILES: C=C(CC)C(=O)OCCC(CCO)CCCc1ccc(-c2ccc(C3CCC(C4CCC(CCCCC)CC4)CC3)c(F)c2F)cc1] |
| 1ϵ-8-27 | 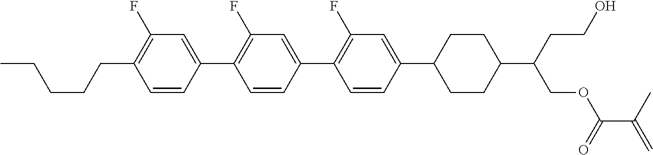 [SMILES: C=C(C)C(=O)OCC(CCO)C1CCC(c2ccc(-c3ccc(-c4ccc(CCCCC)c(F)c4)c(F)c3)c(F)c2)CC1] |
| 1ϵ-8-28 | 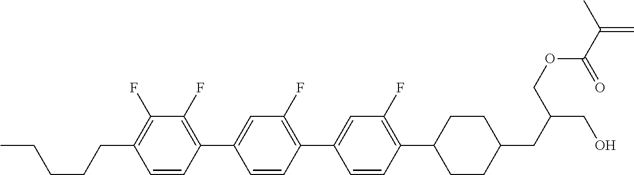 [SMILES: C=C(C)C(=O)OCC(CO)CC1CCC(c2ccc(-c3ccc(-c4ccc(CCCCC)c(F)c4F)cc3F)cc2F)CC1] |
| 1ϵ-8-29 | 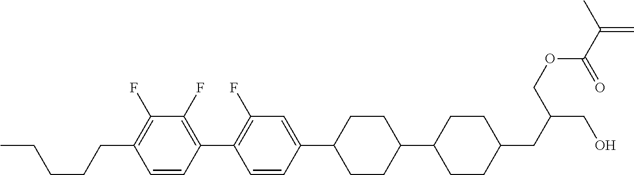 [SMILES: C=C(C)C(=O)OCC(CO)CC1CCC(C2CCC(c3ccc(-c4ccc(CCCCC)c(F)c4F)c(F)c3)CC2)CC1] |
| 1ϵ-8-30 | 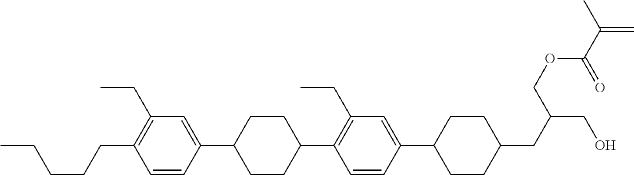 [SMILES: C=C(C)C(=O)OCC(CO)CC1CCC(c2ccc(C3CCC(c4ccc(CCCCC)c(CC)c4)CC3)c(CC)c2)CC1] |
| 1ϵ-8-31 | 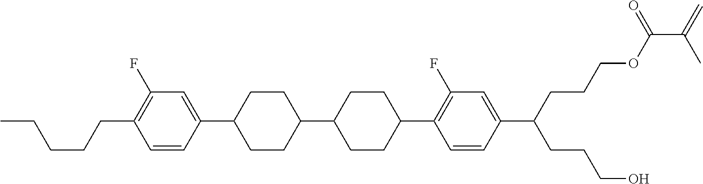 [SMILES: C=C(C)C(=O)OCCCC(CCCO)c1ccc(C2CCC(C3CCC(c4ccc(CCCCC)c(F)c4)CC3)CC2)c(F)c1] |
| 1ϵ-8-32 | 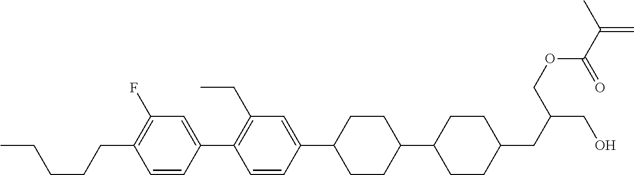 [SMILES: C=C(C)C(=O)OCC(CO)CC1CCC(C2CCC(c3ccc(-c4ccc(CCCCC)c(F)c4)c(CC)c3)CC2)CC1] |
| 1ϵ-8-33 | 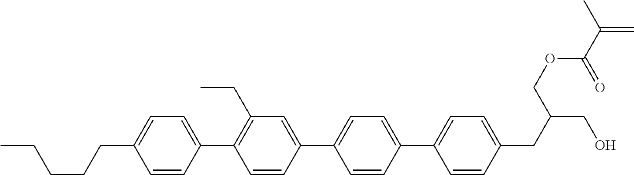 [SMILES: C=C(C)C(=O)OCC(CO)Cc1ccc(-c2ccc(-c3ccc(-c4ccc(CCCCC)cc4)c(CC)c3)cc2)cc1] |
| 1ϵ-8-34 | 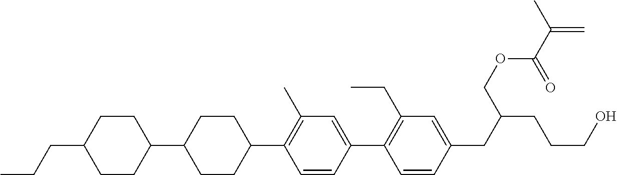 [SMILES: C=C(C)C(=O)OCC(CCCO)Cc1ccc(-c2ccc(C3CCC(C4CCC(CCC)CC4)CC3)c(C)c2)c(CC)c1] |
| 1ϵ-8-35 | 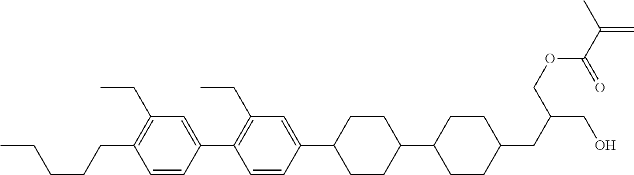 [SMILES: C=C(C)C(=O)OCC(CO)CC1CCC(C2CCC(c3ccc(-c4ccc(CCCCC)c(CC)c4)c(CC)c3)CC2)CC1] |
| 1ϵ-8-36 | 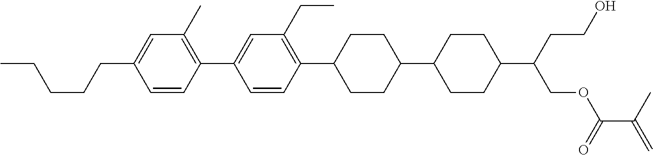 [SMILES: C=C(C)C(=O)OCC(CCO)C1CCC(C2CCC(c3ccc(-c4ccc(CCCCC)cc4C)cc3CC)CC2)CC1] |
| 1ϵ-8-37 | 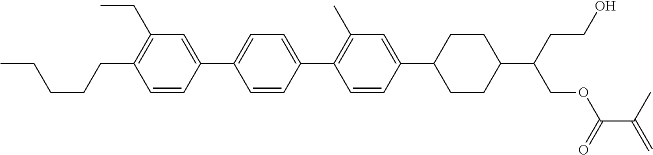 [SMILES: C=C(C)C(=O)OCC(CCO)C1CCC(c2ccc(-c3ccc(-c4ccc(CCCCC)c(CC)c4)cc3)c(C)c2)CC1] |
| 1ϵ-8-38 | 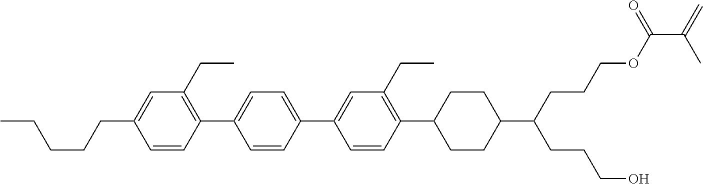 [SMILES: C=C(C)C(=O)OCCCC(CCCO)C1CCC(c2ccc(-c3ccc(-c4ccc(CCCCC)cc4CC)cc3)cc2CC)CC1] |
| 1ϵ-8-39 | 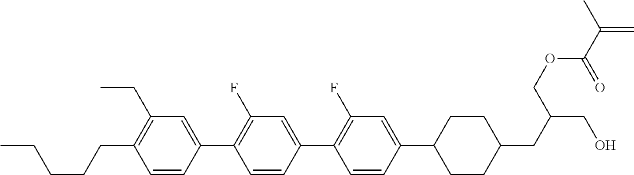 [SMILES: C=C(C)C(=O)OCC(CO)CC1CCC(c2ccc(-c3ccc(-c4ccc(CCCCC)c(CC)c4)c(F)c3)c(F)c2)CC1] |
| 1ϵ-8-40 | 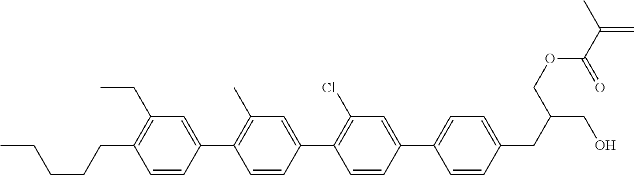 [SMILES: C=C(C)C(=O)OCC(CO)Cc1ccc(-c2ccc(-c3ccc(-c4ccc(CCCCC)c(CC)c4)c(C)c3)c(Cl)c2)cc1] |
| 1ϵ-8-41 | 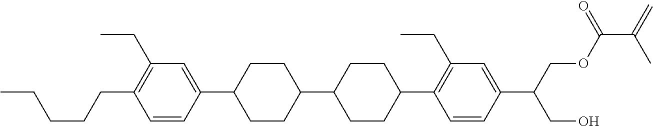 [SMILES: C=C(C)C(=O)OCC(CO)c1ccc(C2CCC(C3CCC(c4ccc(CCCCC)c(CC)c4)CC3)CC2)c(CC)c1] |
| 1ϵ-8-42 | 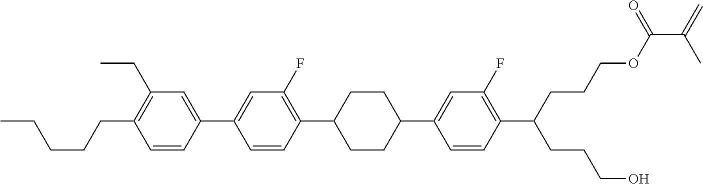 [SMILES: C=C(C)C(=O)OCCCC(CCCO)c1ccc(C2CCC(c3ccc(-c4ccc(CCCCC)c(CC)c4)cc3F)CC2)cc1F] |
| 1ϵ-8-43 | 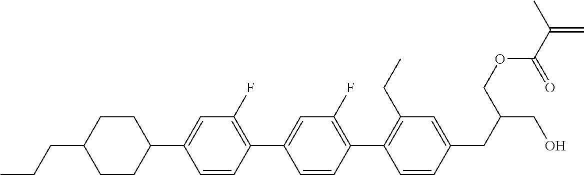 [SMILES: C=C(C)C(=O)OCC(CO)Cc1ccc(-c2ccc(-c3ccc(C4CCC(CCC)CC4)cc3F)cc2F)c(CC)c1] |
| 1ϵ-8-44 | 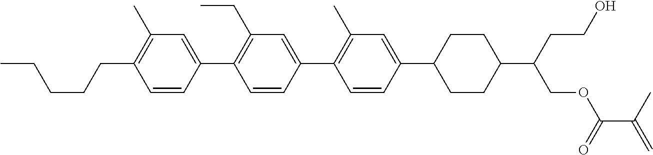 [SMILES: C=C(C)C(=O)OCC(CCO)C1CCC(c2ccc(-c3ccc(-c4ccc(CCCCC)c(C)c4)c(CC)c3)c(C)c2)CC1] |
| 1ϵ-8-45 | 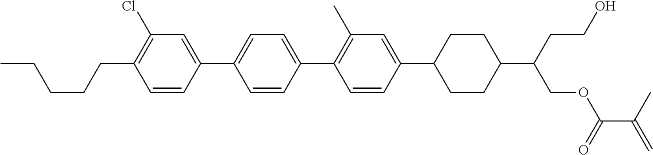 [SMILES: C=C(C)C(=O)OCC(CCO)C1CCC(c2ccc(-c3ccc(-c4ccc(CCCCC)c(Cl)c4)cc3)c(C)c2)CC1] |
| 1ϵ-8-46 | 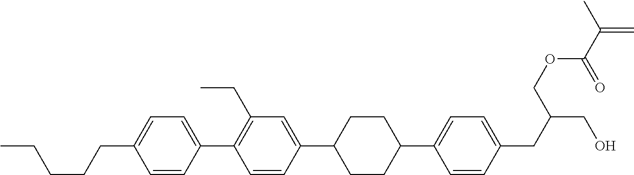 [SMILES: C=C(C)C(=O)OCC(CO)Cc1ccc(C2CCC(c3ccc(-c4ccc(CCCCC)cc4)c(CC)c3)CC2)cc1] |
| 1ϵ-8-47 | 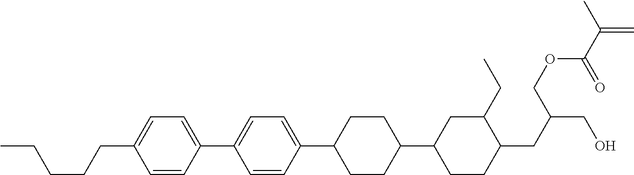 [SMILES: C=C(C)C(=O)OCC(CO)CC1CCC(C2CCC(c3ccc(-c4ccc(CCCCC)cc4)cc3)CC2)CC1CC] |
| 1ϵ-8-48 | 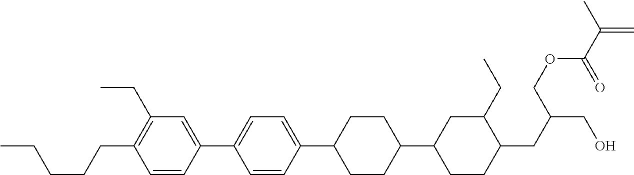 [SMILES: C=C(C)C(=O)OCC(CO)CC1CCC(C2CCC(c3ccc(-c4ccc(CCCCC)c(CC)c4)cc3)CC2)CC1CC] |
| 1ϵ-8-49 | 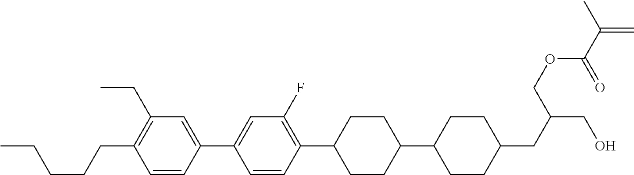 [SMILES: C=C(C)C(=O)OCC(CO)CC1CCC(C2CCC(c3ccc(-c4ccc(CCCCC)c(CC)c4)cc3F)CC2)CC1] |
| 1ϵ-8-50 | 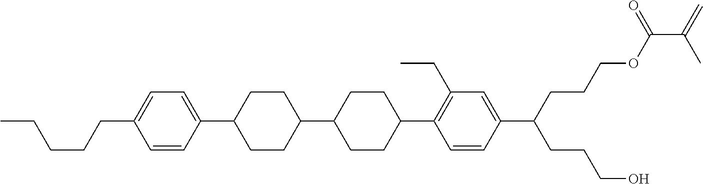 [SMILES: C=C(C)C(=O)OCCCC(CCCO)c1ccc(C2CCC(C3CCC(c4ccc(CCCCC)cc4)CC3)CC2)c(CC)c1] |
| 1ϵ-8-51 | 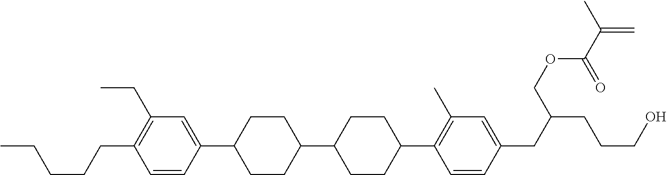 [SMILES: C=C(C)C(=O)OCC(CCCO)Cc1ccc(C2CCC(C3CCC(c4ccc(CCCCC)c(CC)c4)CC3)CC2)c(C)c1] |
| 1ϵ-8-52 | 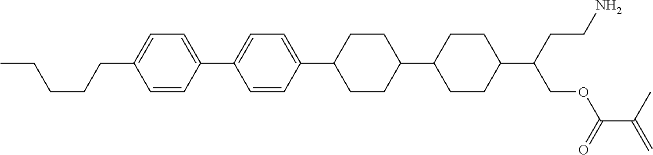 [SMILES: C=C(C)C(=O)OCC(CCN)C1CCC(C2CCC(c3ccc(-c4ccc(CCCCC)cc4)cc3)CC2)CC1] |
| 1ϵ-8-53 | 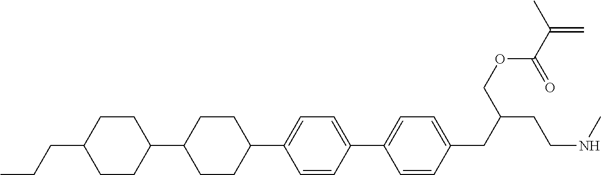 [SMILES: C=C(C)C(=O)OCC(CCNC)Cc1ccc(-c2ccc(C3CCC(C4CCC(CCC)CC4)CC3)cc2)cc1] |
| 1ϵ-8-54 | 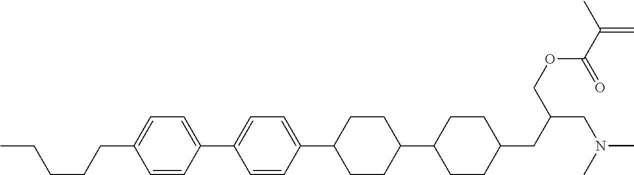 [SMILES: C=C(C)C(=O)OCC(CC1CCC(C2CCC(c3ccc(-c4ccc(CCCCC)cc4)cc3)CC2)CC1)CN(C)C] |
| 1ϵ-8-55 | 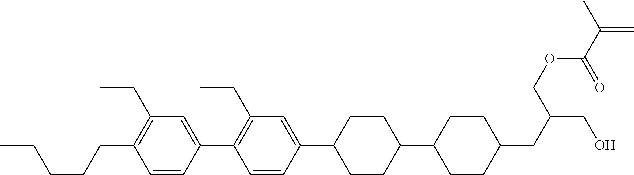 [SMILES: C=C(C)C(=O)OCC(CO)CC1CCC(C2CCC(c3ccc(-c4ccc(CCCCC)c(CC)c4)c(CC)c3)CC2)CC1] |
| 1ϵ-8-56 | 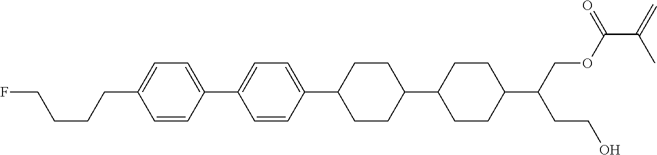 [SMILES: C=C(C)C(=O)OCC(CCO)C1CCC(C2CCC(c3ccc(-c4ccc(CCCCF)cc4)cc3)CC2)CC1] |
| 1ϵ-8-57 | 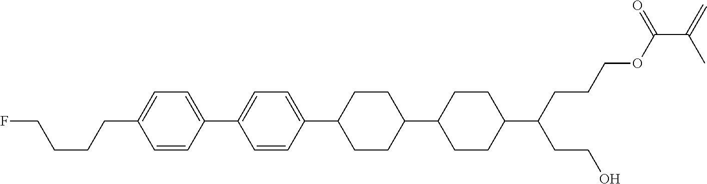 [SMILES: C=C(C)C(=O)OCCCC(CCO)C1CCC(C2CCC(c3ccc(-c4ccc(CCCCF)cc4)cc3)CC2)CC1] |
| 1ϵ-8-58 | 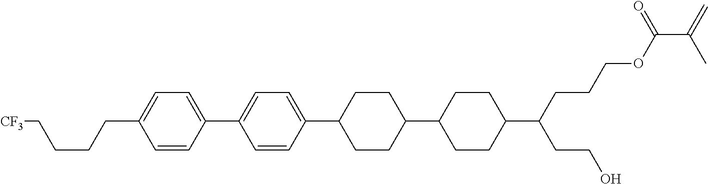 [SMILES: C=C(C)C(=O)OCCCC(CCO)C1CCC(C2CCC(c3ccc(-c4ccc(CCCCC(F)(F)F)cc4)cc3)CC2)CC1] |
| 1ϵ-8-59 | 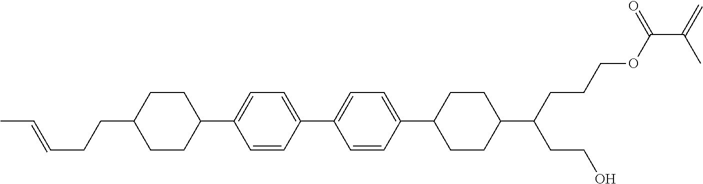 [SMILES: C=C(C)C(=O)OCCCC(CCO)C1CCC(c2ccc(-c3ccc(C4CCC(CC/C=C/C)CC4)cc3)cc2)CC1] |
| 1ϵ-8-60 | 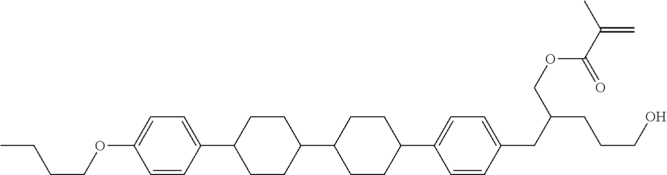 [SMILES: C=C(C)C(=O)OCC(CCCO)Cc1ccc(C2CCC(C3CCC(c4ccc(OCCCC)cc4)CC3)CC2)cc1] |
| 1ϵ-8-61 | 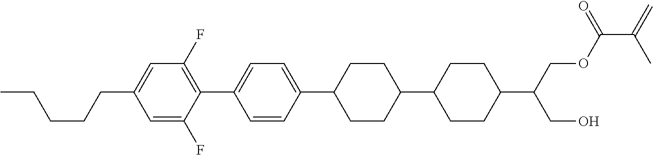 [SMILES: C=C(C)C(=O)OCC(CO)C1CCC(C2CCC(c3ccc(-c4c(F)cc(CCCCC)cc4F)cc3)CC2)CC1] |
| 1ϵ-8-62 | 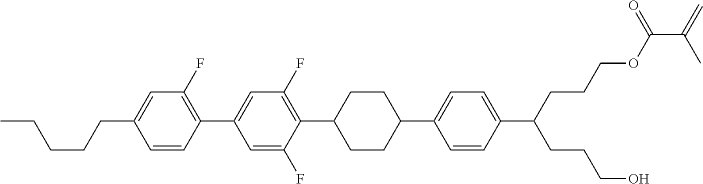 [SMILES: C=C(C)C(=O)OCCCC(CCCO)c1ccc(C2CCC(c3c(F)cc(-c4ccc(CCCCC)cc4F)cc3F)CC2)cc1] |
| 1ϵ-8-63 | 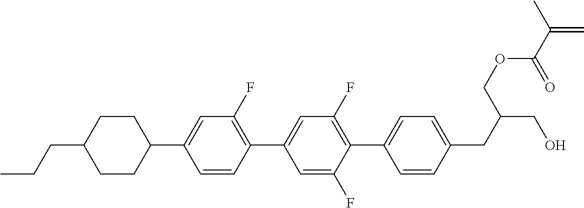 [SMILES: C=C(C)C(=O)OCC(CO)Cc1ccc(-c2c(F)cc(-c3ccc(C4CCC(CCC)CC4)cc3F)cc2F)cc1] |
| 1ϵ-8-64 | 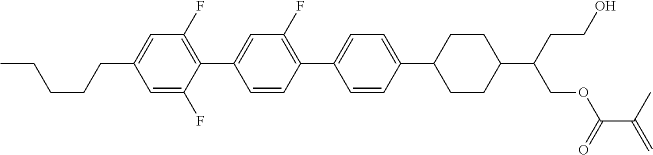 [SMILES: C=C(C)C(=O)OCC(CCO)C1CCC(c2ccc(-c3ccc(-c4c(F)cc(CCCCC)cc4F)cc3F)cc2)CC1] |
| 1ϵ-8-65 | 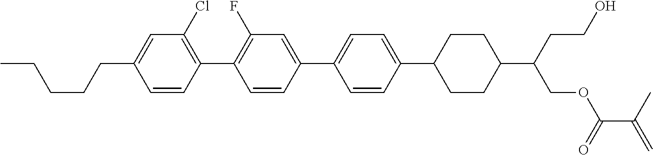 [SMILES: C=C(C)C(=O)OCC(CCO)C1CCC(c2ccc(-c3ccc(-c4ccc(CCCCC)cc4Cl)c(F)c3)cc2)CC1] |
| 1ϵ-8-66 | 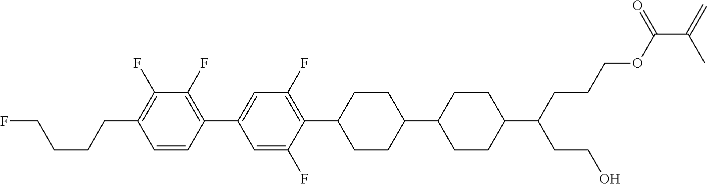 [SMILES: C=C(C)C(=O)OCCCC(CCO)C1CCC(C2CCC(c3c(F)cc(-c4ccc(CCCCF)c(F)c4F)cc3F)CC2)CC1] |
| 1ϵ-8-67 | 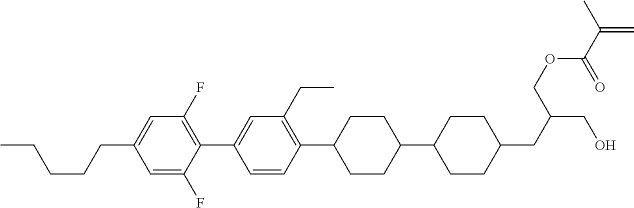 [SMILES: C=C(C)C(=O)OCC(CO)CC1CCC(C2CCC(c3ccc(-c4c(F)cc(CCCCC)cc4F)cc3CC)CC2)CC1] |
| 1ϵ-8-68 | 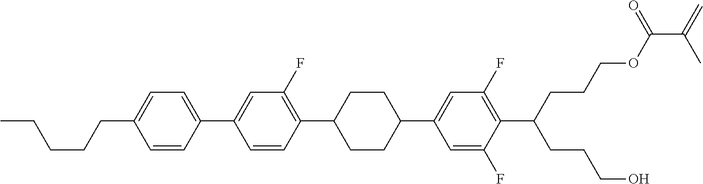 [SMILES: C=C(C)C(=O)OCCCC(CCCO)c1c(F)cc(C2CCC(c3ccc(-c4ccc(CCCCC)cc4)cc3F)CC2)cc1F] |
| 1ϵ-8-69 | 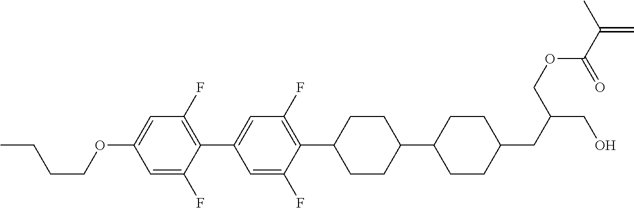 [SMILES: C=C(C)C(=O)OCC(CO)CC1CCC(C2CCC(c3c(F)cc(-c4c(F)cc(OCCCC)cc4F)cc3F)CC2)CC1] |
| 1ϵ-8-70 | 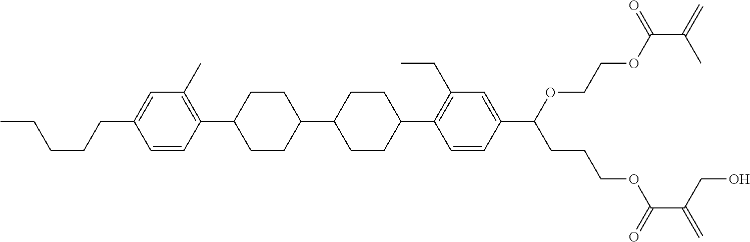 [SMILES: C=C(C)C(=O)OCCOC(CCCOC(=O)C(=C)CO)c1ccc(C2CCC(C3CCC(c4ccc(CCCCC)cc4C)CC3)CC2)c(CC)c1] |
| 1ϵ-8-71 | 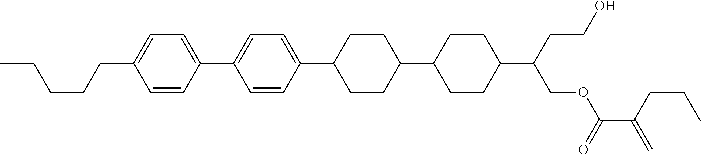 [SMILES: C=C(CCC)C(=O)OCC(CCO)C1CCC(C2CCC(c3ccc(-c4ccc(CCCCC)cc4)cc3)CC2)CC1] |
| 1ϵ-8-72 | 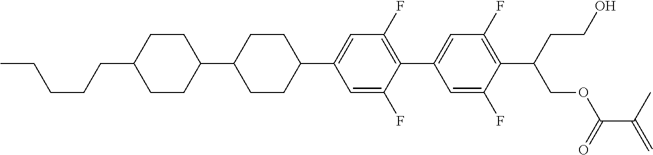 [SMILES: C=C(C)C(=O)OCC(CCO)c1c(F)cc(-c2c(F)cc(C3CCC(C4CCC(CCCCC)CC4)CC3)cc2F)cc1F] |
| 1ϵ-8-73 | 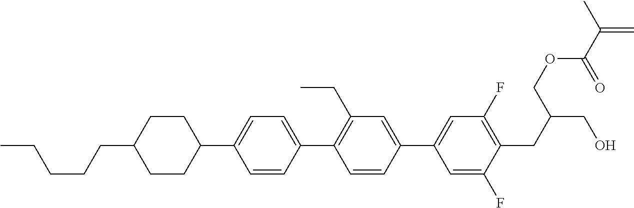 [SMILES: C=C(C)C(=O)OCC(CO)Cc1c(F)cc(-c2ccc(-c3ccc(C4CCC(CCCCC)CC4)cc3)c(CC)c2)cc1F] |
| 1ϵ-8-74 | 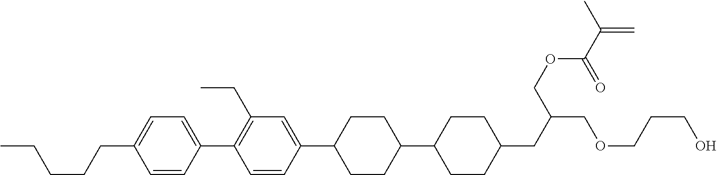 [SMILES: C=C(C)C(=O)OCC(COCCCO)CC1CCC(C2CCC(c3ccc(-c4ccc(CCCCC)cc4)c(CC)c3)CC2)CC1] |
| 1ϵ-8-75 | 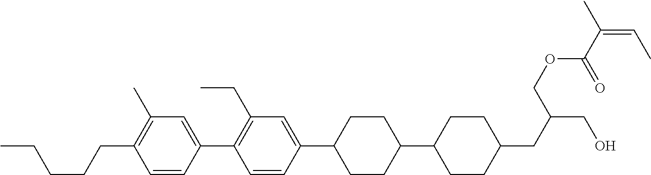 [SMILES: C/C=C(/C)C(=O)OCC(CO)CC1CCC(C2CCC(c3ccc(-c4ccc(CCCCC)c(C)c4)c(CC)c3)CC2)CC1] |
| 1ϵ-8-76 | 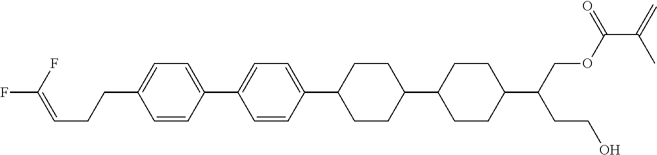 [SMILES: C=C(C)C(=O)OCC(CCO)C1CCC(C2CCC(c3ccc(-c4ccc(CCC=C(F)F)cc4)cc3)CC2)CC1] |
| 1ϵ-8-77 | 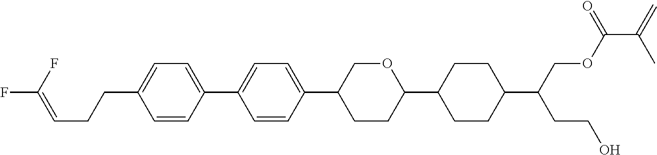 [SMILES: C=C(C)C(=O)OCC(CCO)C1CCC(C2CCC(c3ccc(-c4ccc(CCC=C(F)F)cc4)cc3)CO2)CC1] |
| 1ϵ-8-78 | 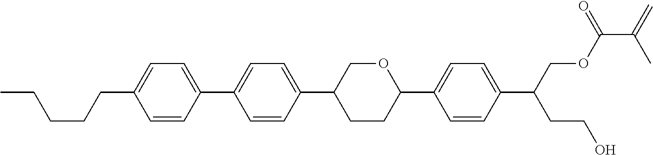 [SMILES: C=C(C)C(=O)OCC(CCO)c1ccc(C2CCC(c3ccc(-c4ccc(CCCCC)cc4)cc3)CO2)cc1] |
| 1ϵ-8-79 | 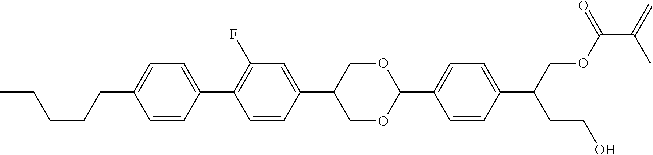 [SMILES: C=C(C)C(=O)OCC(CCO)c1ccc(C2OCC(c3ccc(-c4ccc(CCCCC)cc4)c(F)c3)CO2)cc1] |
| 1ϵ-8-80 | 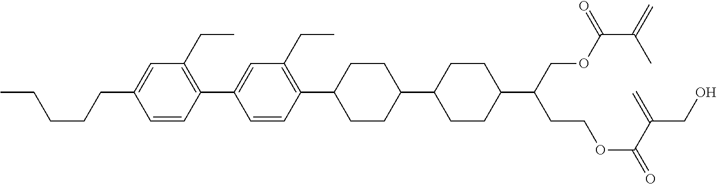 [SMILES: C=C(C)C(=O)OCC(CCOC(=O)C(=C)CO)C1CCC(C2CCC(c3ccc(-c4ccc(CCCCC)cc4CC)cc3CC)CC2)CC1] |
| 1ϵ-8-81 | 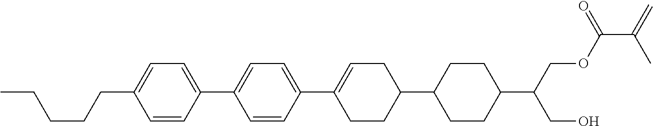 [SMILES: C=C(C)C(=O)OCC(CO)C1CCC(C2CC=C(c3ccc(-c4ccc(CCCCC)cc4)cc3)CC2)CC1] |
| 1ϵ-8-82 | 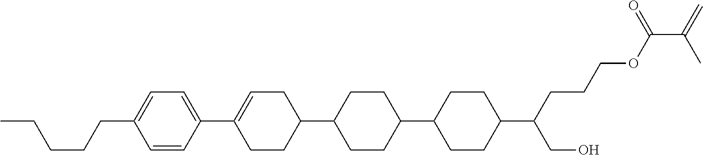 [SMILES: C=C(C)C(=O)OCCCC(CO)C1CCC(C2CCC(C3CC=C(c4ccc(CCCCC)cc4)CC3)CC2)CC1] |
| 1ϵ-8-83 | 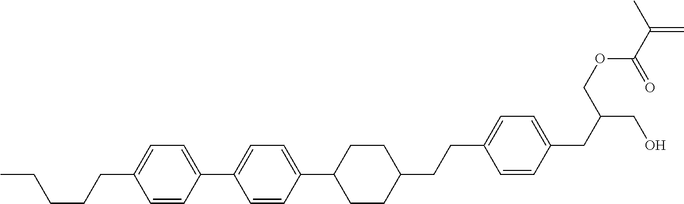 [SMILES: C=C(C)C(=O)OCC(CO)Cc1ccc(CCC2CCC(c3ccc(-c4ccc(CCCCC)cc4)cc3)CC2)cc1] |
| 1ϵ-8-84 | 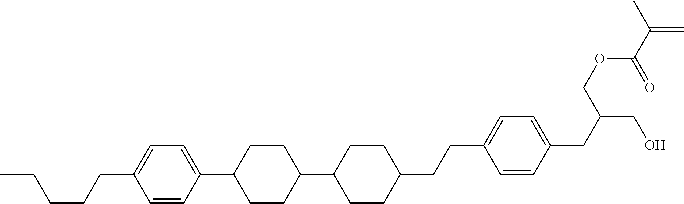 [SMILES: C=C(C)C(=O)OCC(CO)Cc1ccc(CCC2CCC(C3CCC(c4ccc(CCCCC)cc4)CC3)CC2)cc1] |
| 1ϵ-8-85 | 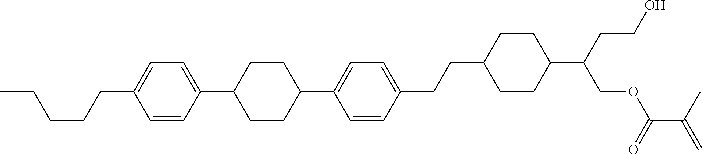 [SMILES: C=C(C)C(=O)OCC(CCO)C1CCC(CCc2ccc(C3CCC(c4ccc(CCCCC)cc4)CC3)cc2)CC1] |
| 1ϵ-8-86 | 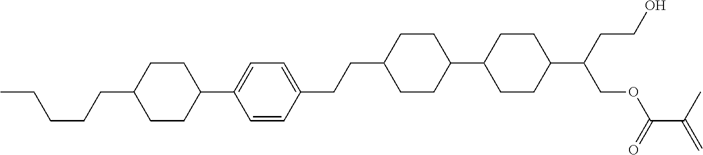 [SMILES: C=C(C)C(=O)OCC(CCO)C1CCC(C2CCC(CCc3ccc(C4CCC(CCCCC)CC4)cc3)CC2)CC1] |
| 1ϵ-8-87 | 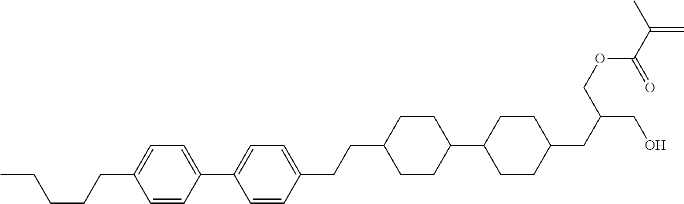 [SMILES: C=C(C)C(=O)OCC(CO)CC1CCC(C2CCC(CCc3ccc(-c4ccc(CCCCC)cc4)cc3)CC2)CC1] |
| 1ϵ-8-88 | 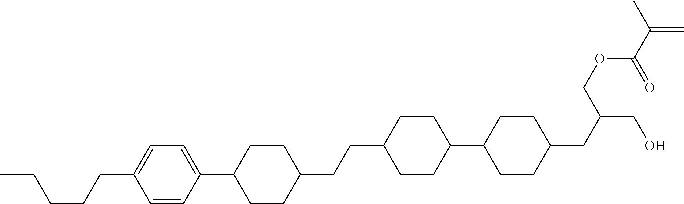 [SMILES: C=C(C)C(=O)OCC(CO)CC1CCC(C2CCC(CCC3CCC(c4ccc(CCCCC)cc4)CC3)CC2)CC1] |
| 1ϵ-8-89 | 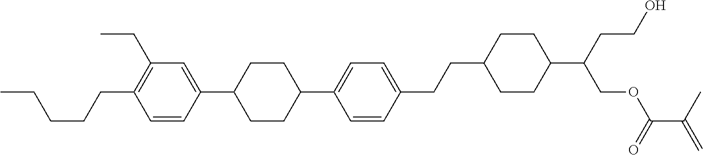 [SMILES: C=C(C)C(=O)OCC(CCO)C1CCC(CCc2ccc(C3CCC(c4ccc(CCCCC)c(CC)c4)CC3)cc2)CC1] |
| 1ϵ-8-90 | 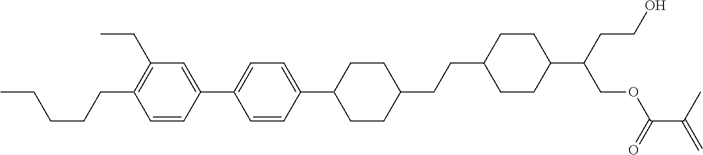 [SMILES: C=C(C)C(=O)OCC(CCO)C1CCC(CCC2CCC(c3ccc(-c4ccc(CCCCC)c(CC)c4)cc3)CC2)CC1] |
| 1ϵ-8-91 | 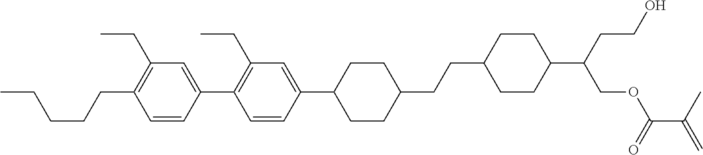 [SMILES: C=C(C)C(=O)OCC(CCO)C1CCC(CCC2CCC(c3ccc(-c4ccc(CCCCC)c(CC)c4)c(CC)c3)CC2)CC1] |
| 1ϵ-8-92 | 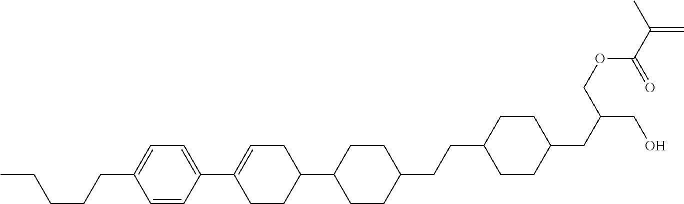 [SMILES: C=C(C)C(=O)OCC(CO)CC1CCC(CCC2CCC(C3CC=C(c4ccc(CCCCC)cc4)CC3)CC2)CC1] |
| 1ϵ-8-93 | 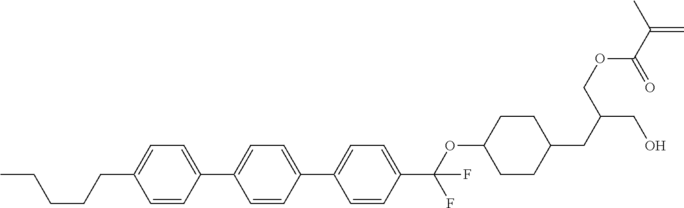 [SMILES: C=C(C)C(=O)OCC(CO)CC1CCC(OC(F)(F)c2ccc(-c3ccc(-c4ccc(CCCCC)cc4)cc3)cc2)CC1] |
| 1ϵ-8-94 | 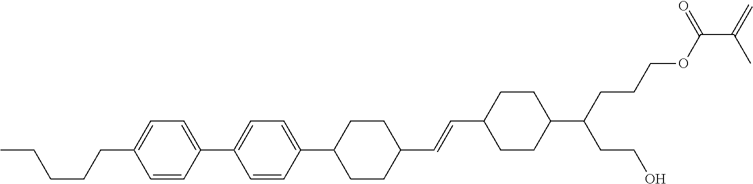 [SMILES: C=C(C)C(=O)OCCCC(CCO)C1CCC(/C=C/C2CCC(c3ccc(-c4ccc(CCCCC)cc4)cc3)CC2)CC1] |
| 1ϵ-8-95 | 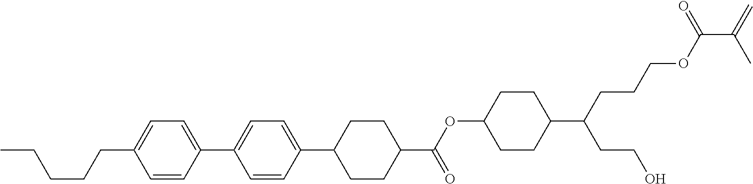 [SMILES: C=C(C)C(=O)OCCCC(CCO)C1CCC(OC(=O)C2CCC(c3ccc(-c4ccc(CCCCC)cc4)cc3)CC2)CC1] |
| 1ϵ-8-96 | 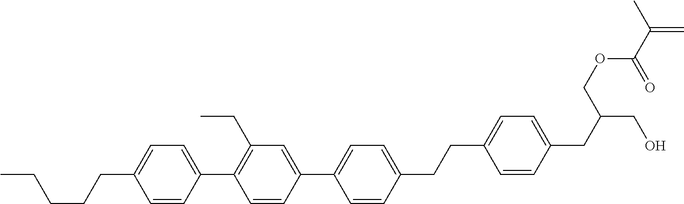 [SMILES: C=C(C)C(=O)OCC(CO)Cc1ccc(CCc2ccc(-c3ccc(-c4ccc(CCCCC)cc4)c(CC)c3)cc2)cc1] |
| 1ϵ-8-97 | 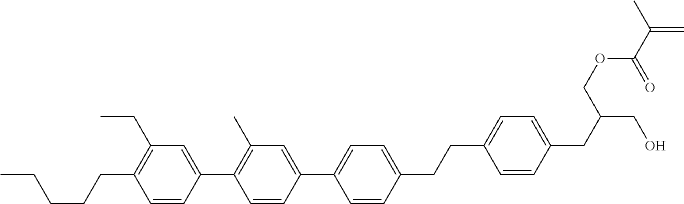 [SMILES: C=C(C)C(=O)OCC(CO)Cc1ccc(CCc2ccc(-c3ccc(-c4ccc(CCCCC)c(CC)c4)c(C)c3)cc2)cc1] |
| 1ϵ-8-98 | 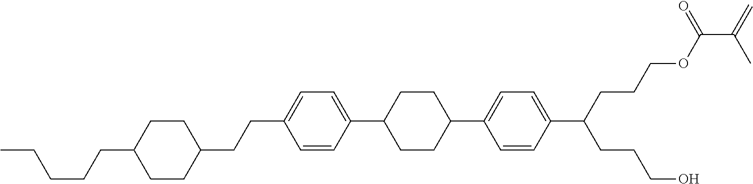 [SMILES: C=C(C)C(=O)OCCCC(CCCO)c1ccc(C2CCC(c3ccc(CCC4CCC(CCCCC)CC4)cc3)CC2)cc1] |
| 1ϵ-8-99 | 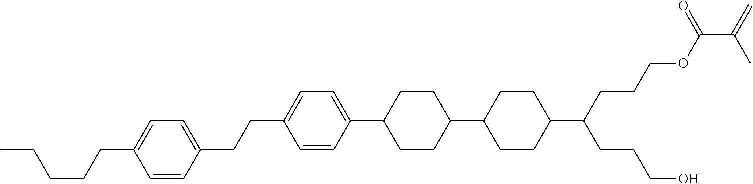 [SMILES: C=C(C)C(=O)OCCCC(CCCO)C1CCC(C2CCC(c3ccc(CCc4ccc(CCCCC)cc4)cc3)CC2)CC1] |
| 1ϵ-8-100 | 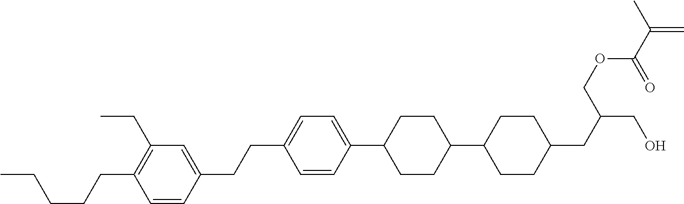 [SMILES: C=C(C)C(=O)OCC(CO)CC1CCC(C2CCC(c3ccc(CCc4ccc(CCCCC)c(CC)c4)cc3)CC2)CC1] |
| 1ϵ-8-101 | 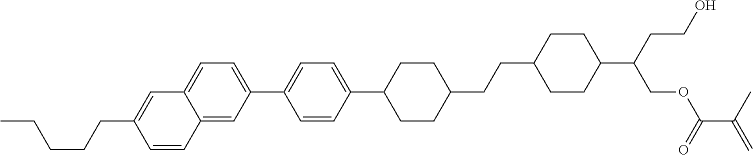 [SMILES: C=C(C)C(=O)OCC(CCO)C1CCC(CCC2CCC(c3ccc(-c4ccc5cc(CCCCC)ccc5c4)cc3)CC2)CC1] |
| 1ϵ-8-102 | 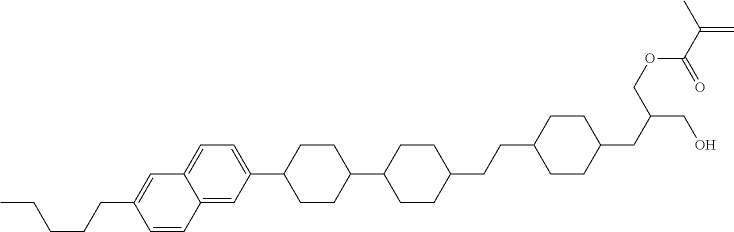 [SMILES: C=C(C)C(=O)OCC(CO)CC1CCC(CCC2CCC(C3CCC(c4ccc5cc(CCCCC)ccc5c4)CC3)CC2)CC1] |
| 1ϵ-8-103 | 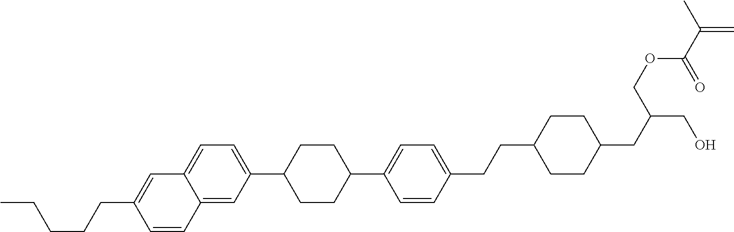 [SMILES: C=C(C)C(=O)OCC(CO)CC1CCC(CCc2ccc(C3CCC(c4ccc5cc(CCCCC)ccc5c4)CC3)cc2)CC1] |
| 1ϵ-8-104 | 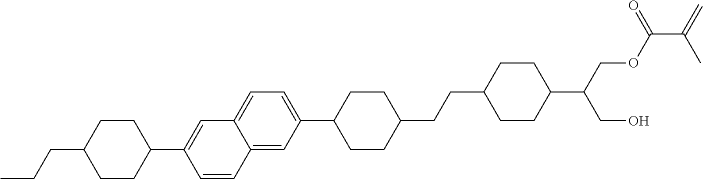 [SMILES: C=C(C)C(=O)OCC(CO)C1CCC(CCC2CCC(c3ccc4cc(C5CCC(CCC)CC5)ccc4c3)CC2)CC1] |
| 1ϵ-8-105 | 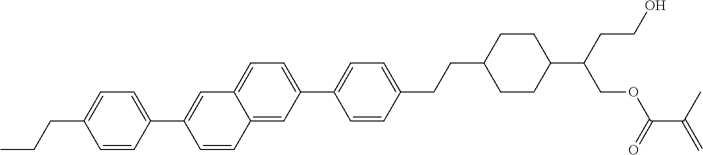 [SMILES: C=C(C)C(=O)OCC(CCO)C1CCC(CCc2ccc(-c3ccc4cc(-c5ccc(CCC)cc5)ccc4c3)cc2)CC1] |
| 1ϵ-8-106 | 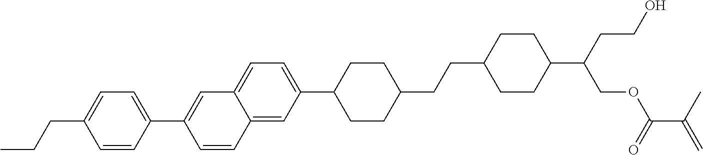 [SMILES: C=C(C)C(=O)OCC(CCO)C1CCC(CCC2CCC(c3ccc4cc(-c5ccc(CCC)cc5)ccc4c3)CC2)CC1] |
| 1ϵ-8-107 | 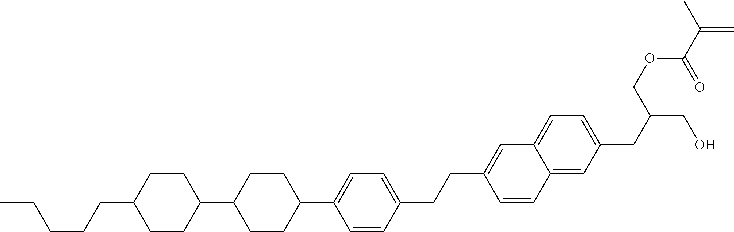 [SMILES: C=C(C)C(=O)OCC(CO)Cc1ccc2cc(CCc3ccc(C4CCC(C5CCC(CCCCC)CC5)CC4)cc3)ccc2c1] |
| 1ϵ-8-108 | 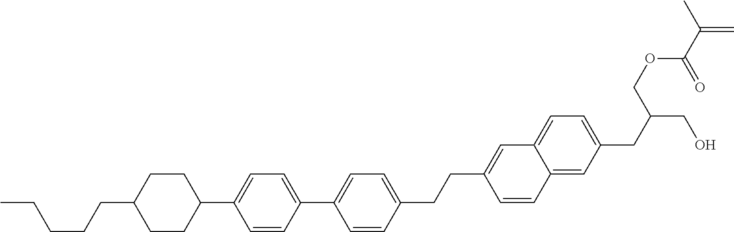 [SMILES: C=C(C)C(=O)OCC(CO)Cc1ccc2cc(CCc3ccc(-c4ccc(C5CCC(CCCCC)CC5)cc4)cc3)ccc2c1] |
| 1ϵ-8-109 | 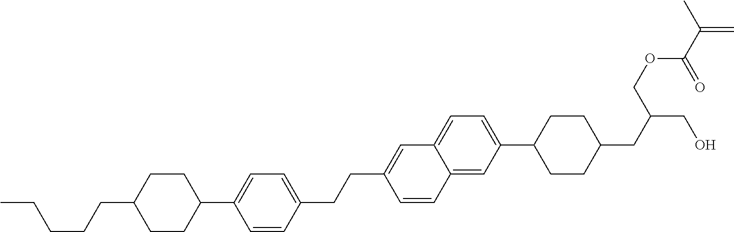 [SMILES: C=C(C)C(=O)OCC(CO)CC1CCC(c2ccc3cc(CCc4ccc(C5CCC(CCCCC)CC5)cc4)ccc3c2)CC1] |
| 1ϵ-8-110 | 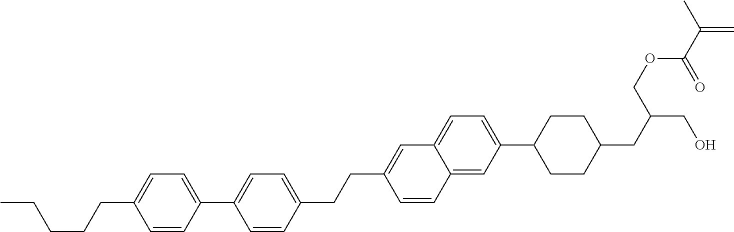 [SMILES: C=C(C)C(=O)OCC(CO)CC1CCC(c2ccc3cc(CCc4ccc(-c5ccc(CCCCC)cc5)cc4)ccc3c2)CC1] |
| 1ϵ-8-111 | 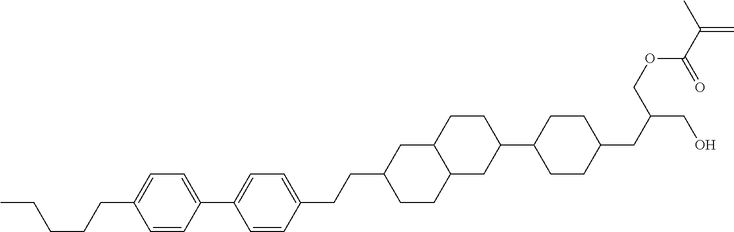 [SMILES: C=C(C)C(=O)OCC(CO)CC1CCC(C2CCC3CC(CCc4ccc(-c5ccc(CCCCC)cc5)cc4)CCC3C2)CC1] |
| 1ϵ-8-112 | 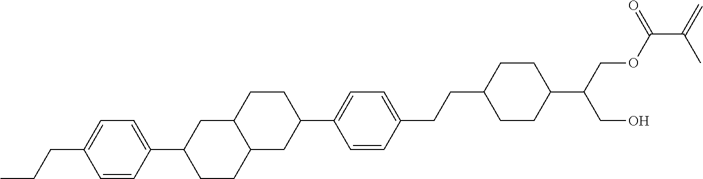 [SMILES: C=C(C)C(=O)OCC(CO)C1CCC(CCc2ccc(C3CCC4CC(c5ccc(CCC)cc5)CCC4C3)cc2)CC1] |
| 1ϵ-8-113 | 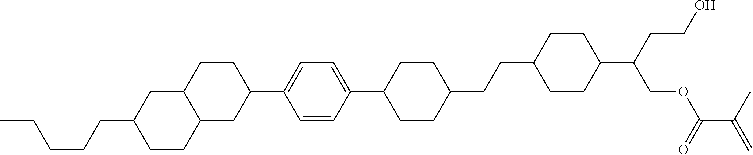 [SMILES: C=C(C)C(=O)OCC(CCO)C1CCC(CCC2CCC(c3ccc(C4CCC5CC(CCCCC)CCC5C4)cc3)CC2)CC1] |
| 1ϵ-8-114 | 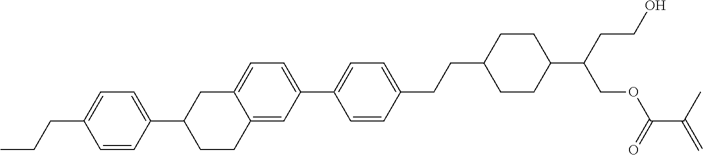 [SMILES: C=C(C)C(=O)OCC(CCO)C1CCC(CCc2ccc(-c3ccc4c(c3)CCC(c3ccc(CCC)cc3)C4)cc2)CC1] |
| 1ϵ-8-115 | 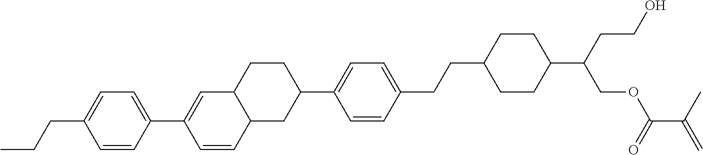 [SMILES: C=C(C)C(=O)OCC(CCO)C1CCC(CCc2ccc(C3CCC4C=C(c5ccc(CCC)cc5)C=CC4C3)cc2)CC1] |
| 1ϵ-8-116 | 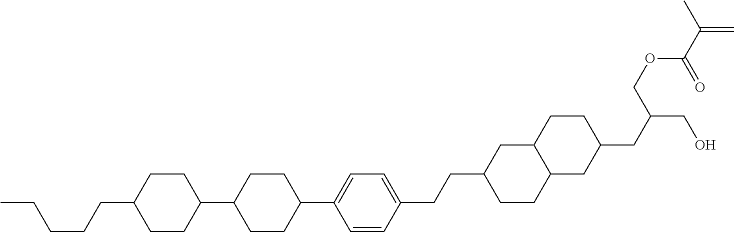 [SMILES: C=C(C)C(=O)OCC(CO)CC1CCC2CC(CCc3ccc(C4CCC(C5CCC(CCCCC)CC5)CC4)cc3)CCC2C1] |
| 1ϵ-8-117 | 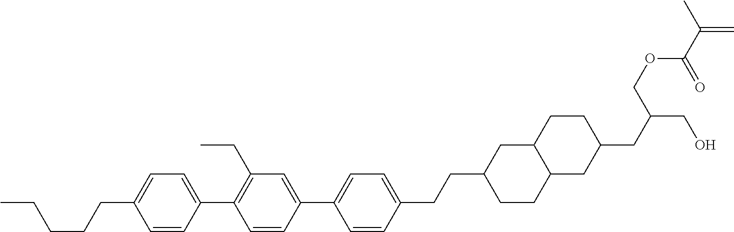 [SMILES: C=C(C)C(=O)OCC(CO)CC1CCC2CC(CCc3ccc(-c4ccc(-c5ccc(CCCCC)cc5)c(CC)c4)cc3)CCC2C1] |
| 1ϵ-8-118 | 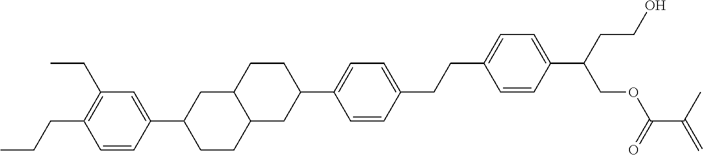 [SMILES: C=C(C)C(=O)OCC(CCO)c1ccc(CCc2ccc(C3CCC4CC(c5ccc(CCC)c(CC)c5)CCC4C3)cc2)cc1] |
| 1ϵ-8-119 | 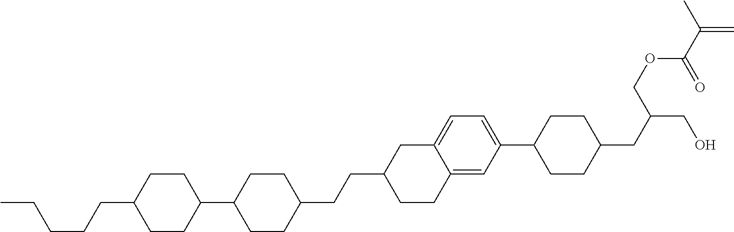 [SMILES: C=C(C)C(=O)OCC(CO)CC1CCC(c2ccc3c(c2)CCC(CCC2CCC(C4CCC(CCCCC)CC4)CC2)C3)CC1] |
| 1ϵ-8-120 | 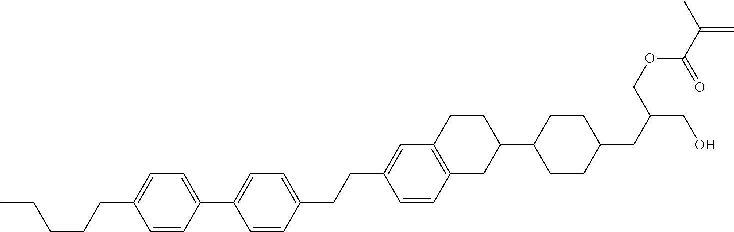 [SMILES: C=C(C)C(=O)OCC(CO)CC1CCC(C2CCc3cc(CCc4ccc(-c5ccc(CCCCC)cc5)cc4)ccc3C2)CC1] |
| 1ϵ-8-121 | 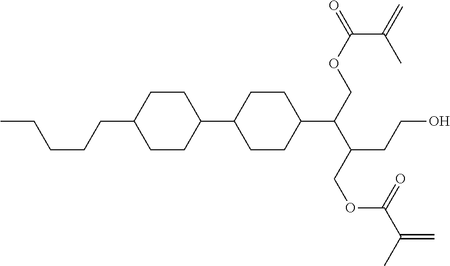 [SMILES: C=C(C)C(=O)OCC(CCO)C(COC(=O)C(=C)C)C1CCC(C2CCC(CCCCC)CC2)CC1] |
| 1ϵ-8-122 | 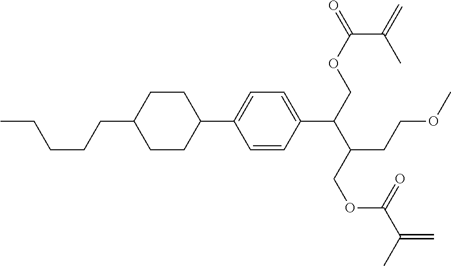 [SMILES: C=C(C)C(=O)OCC(CCOC)C(COC(=O)C(=C)C)c1ccc(C2CCC(CCCCC)CC2)cc1] |
| 1ϵ-8-123 | 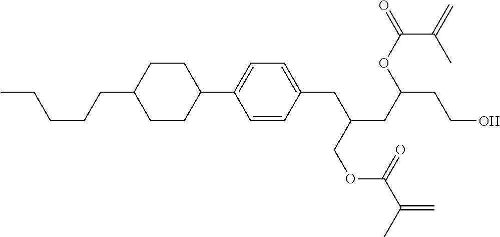 [SMILES: C=C(C)C(=O)OCC(Cc1ccc(C2CCC(CCCCC)CC2)cc1)CC(CCO)OC(=O)C(=C)C] |
| 1ϵ-8-124 | 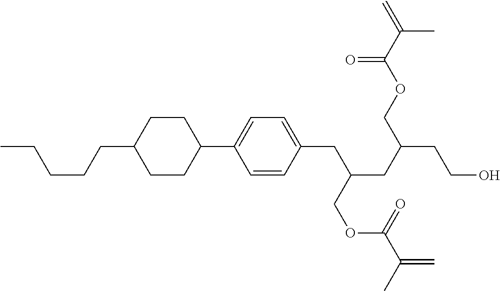 [SMILES: C=C(C)C(=O)OCC(CCO)CC(COC(=O)C(=C)C)Cc1ccc(C2CCC(CCCCC)CC2)cc1] |
| 1ϵ-8-125 | 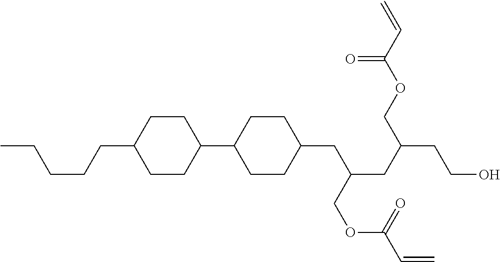 [SMILES: C=CC(=O)OCC(CCO)CC(COC(=O)C=C)CC1CCC(C2CCC(CCCCC)CC2)CC1] |
| 1ϵ-8-126 | 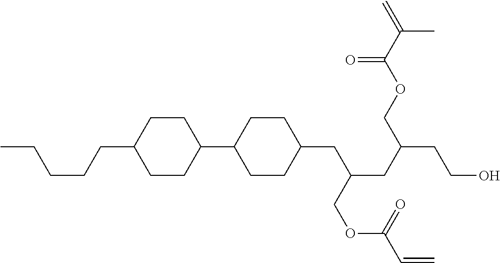 [SMILES: C=CC(=O)OCC(CC1CCC(C2CCC(CCCCC)CC2)CC1)CC(CCO)COC(=O)C(=C)C] |
| 1ϵ-8-127 | 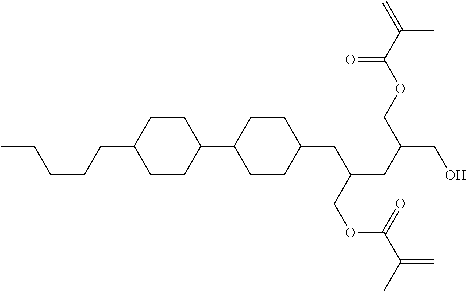 [SMILES: C=C(C)C(=O)OCC(CO)CC(COC(=O)C(=C)C)CC1CCC(C2CCC(CCCCC)CC2)CC1] |
| 1ϵ-8-128 | 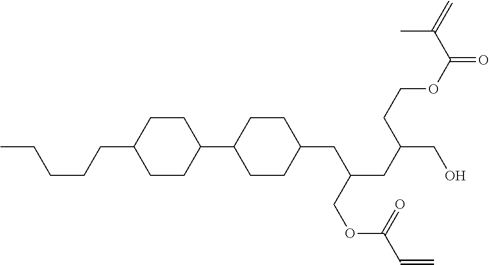 [SMILES: C=CC(=O)OCC(CC(CO)CCOC(=O)C(=C)C)CC1CCC(C2CCC(CCCCC)CC2)CC1] |
| 1ϵ-8-131 | 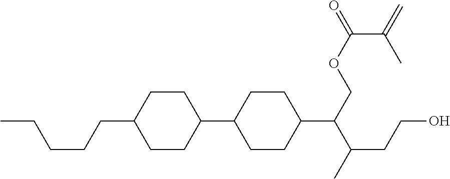 [SMILES: C=C(C)C(=O)OCC(C(C)CCO)C1CCC(C2CCC(CCCCC)CC2)CC1] |
| 1ϵ-8-132 | 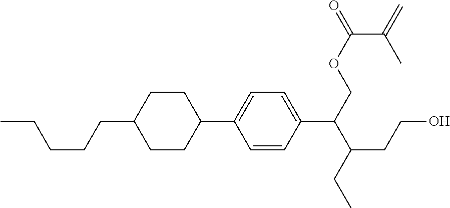 [SMILES: C=C(C)C(=O)OCC(c1ccc(C2CCC(CCCCC)CC2)cc1)C(CC)CCO] |
| 1ϵ-8-133 | 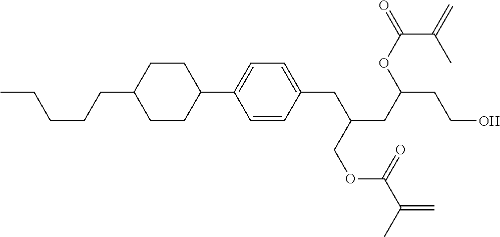 [SMILES: C=C(C)C(=O)OCC(Cc1ccc(C2CCC(CCCCC)CC2)cc1)CC(CCO)OC(=O)C(=C)C] |
| 1ϵ-8-134 | 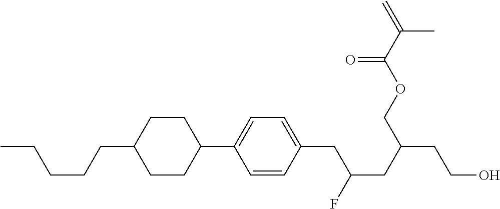 [SMILES: C=C(C)C(=O)OCC(CCO)CC(F)Cc1ccc(C2CCC(CCCCC)CC2)cc1] |
| 1ϵ-9-1 | 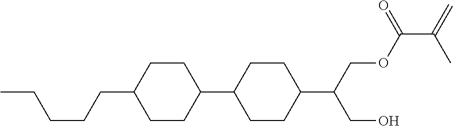 [SMILES: C=C(C)C(=O)OCC(CO)C1CCC(C2CCC(CCCCC)CC2)CC1] |
| 1ϵ-9-2 | 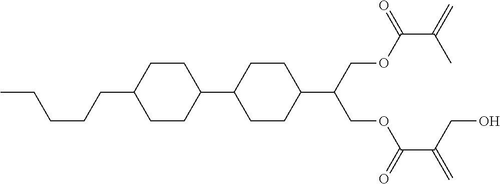 [SMILES: C=C(C)C(=O)OCC(COC(=O)C(=C)CO)C1CCC(C2CCC(CCCCC)CC2)CC1] |
| 1ϵ-9-3 | 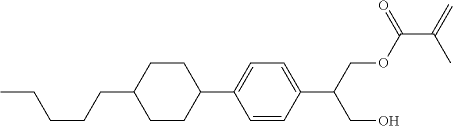 [SMILES: C=C(C)C(=O)OCC(CO)c1ccc(C2CCC(CCCCC)CC2)cc1] |
| 1ϵ-9-4 | 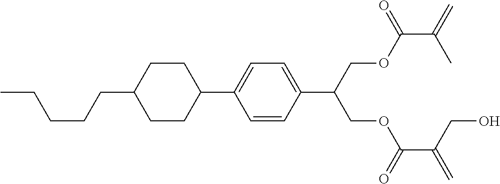 [SMILES: C=C(C)C(=O)OCC(COC(=O)C(=C)CO)c1ccc(C2CCC(CCCCC)CC2)cc1] |
| 1ϵ-9-5 | 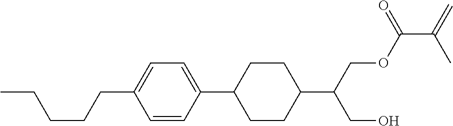 [SMILES: C=C(C)C(=O)OCC(CO)C1CCC(c2ccc(CCCCC)cc2)CC1] |
| 1ϵ-9-6 | 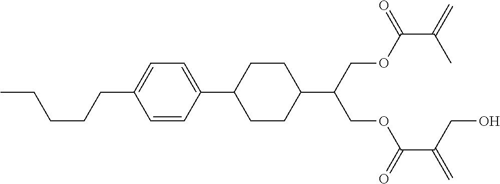 [SMILES: C=C(C)C(=O)OCC(COC(=O)C(=C)CO)C1CCC(c2ccc(CCCCC)cc2)CC1] |
| 1ϵ-9-7 | 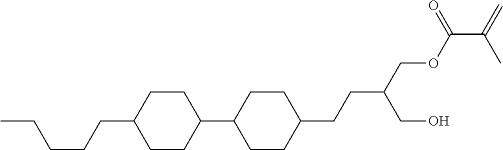 [SMILES: C=C(C)C(=O)OCC(CO)CCC1CCC(C2CCC(CCCCC)CC2)CC1] |
| 1ϵ-9-8 | 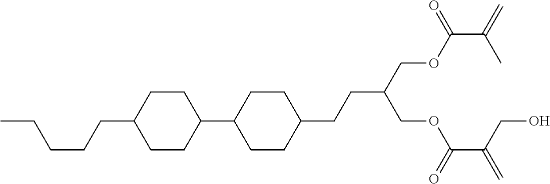 [SMILES: C=C(C)C(=O)OCC(CCC1CCC(C2CCC(CCCCC)CC2)CC1)COC(=O)C(=C)CO] |
| 1ϵ-9-9 | 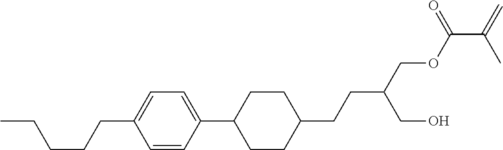 [SMILES: C=C(C)C(=O)OCC(CO)CCC1CCC(c2ccc(CCCCC)cc2)CC1] |
| 1ϵ-9-10 | 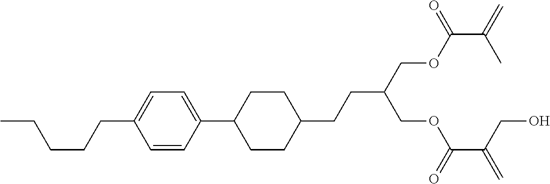 [SMILES: C=C(C)C(=O)OCC(CCC1CCC(c2ccc(CCCCC)cc2)CC1)COC(=O)C(=C)CO] |
| 1ϵ-9-11 | 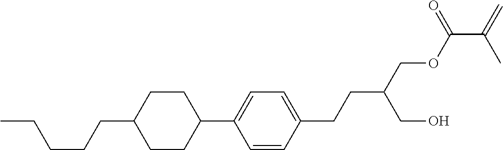 [SMILES: C=C(C)C(=O)OCC(CO)CCc1ccc(C2CCC(CCCCC)CC2)cc1] |
| 1ϵ-9-12 | 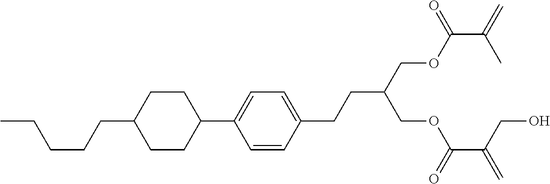 [SMILES: C=C(C)C(=O)OCC(CCc1ccc(C2CCC(CCCCC)CC2)cc1)COC(=O)C(=C)CO] |
| 1ϵ-9-13 | 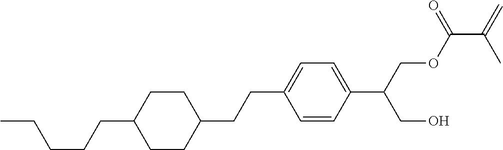 [SMILES: C=C(C)C(=O)OCC(CO)c1ccc(CCC2CCC(CCCCC)CC2)cc1] |
| 1ϵ-9-14 | 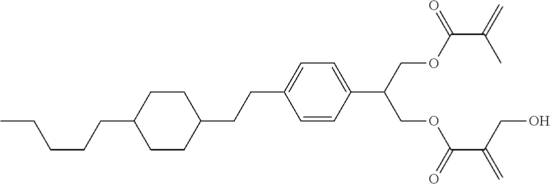 [SMILES: C=C(C)C(=O)OCC(COC(=O)C(=C)CO)c1ccc(CCC2CCC(CCCCC)CC2)cc1] |
| 1ϵ-9-15 | 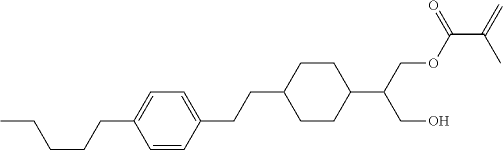 [SMILES: C=C(C)C(=O)OCC(CO)C1CCC(CCc2ccc(CCCCC)cc2)CC1] |
| 1ϵ-9-16 | 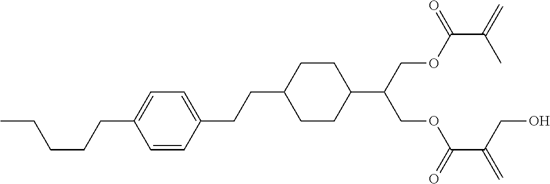 [SMILES: C=C(C)C(=O)OCC(COC(=O)C(=C)CO)C1CCC(CCc2ccc(CCCCC)cc2)CC1] |
| 1ϵ-9-17 | 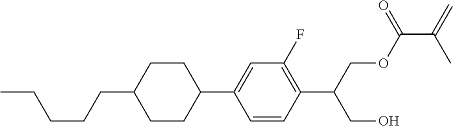 [SMILES: C=C(C)C(=O)OCC(CO)c1ccc(C2CCC(CCCCC)CC2)cc1F] |
| 1ϵ-9-18 | 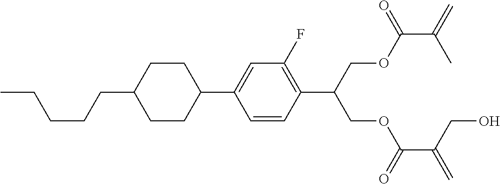 [SMILES: C=C(C)C(=O)OCC(COC(=O)C(=C)CO)c1ccc(C2CCC(CCCCC)CC2)cc1F] |
| 1ϵ-9-19 | 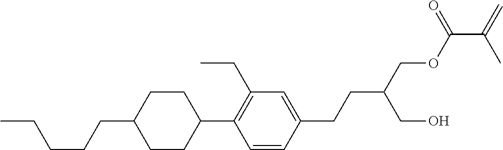 [SMILES: C=C(C)C(=O)OCC(CO)CCc1ccc(C2CCC(CCCCC)CC2)c(CC)c1] |
| 1ϵ-9-20 | 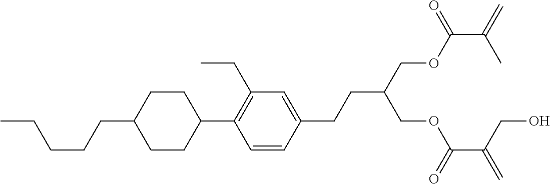 [SMILES: C=C(C)C(=O)OCC(CCc1ccc(C2CCC(CCCCC)CC2)c(CC)c1)COC(=O)C(=C)CO] |
| 1ϵ-9-21 | 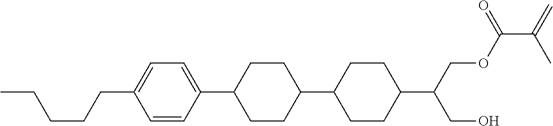 [SMILES: C=C(C)C(=O)OCC(CO)C1CCC(C2CCC(c3ccc(CCCCC)cc3)CC2)CC1] |
| 1ϵ-9-22 | 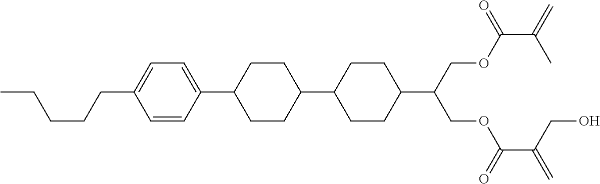 [SMILES: C=C(C)C(=O)OCC(COC(=O)C(=C)CO)C1CCC(C2CCC(c3ccc(CCCCC)cc3)CC2)CC1] |
| 1ϵ-9-23 | 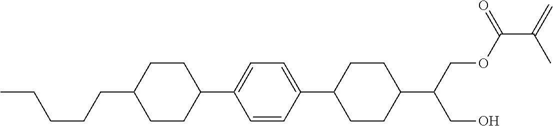 [SMILES: C=C(C)C(=O)OCC(CO)C1CCC(c2ccc(C3CCC(CCCCC)CC3)cc2)CC1] |
| 1ϵ-9-24 | 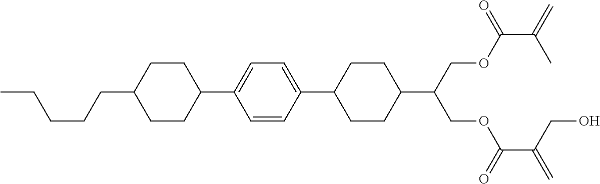 [SMILES: C=C(C)C(=O)OCC(COC(=O)C(=C)CO)C1CCC(c2ccc(C3CCC(CCCCC)CC3)cc2)CC1] |
| 1ϵ-9-25 | 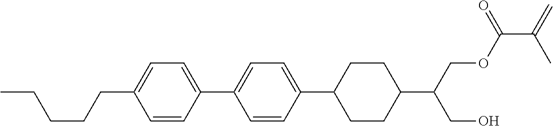 [SMILES: C=C(C)C(=O)OCC(CO)C1CCC(c2ccc(-c3ccc(CCCCC)cc3)cc2)CC1] |
| 1ϵ-9-26 | 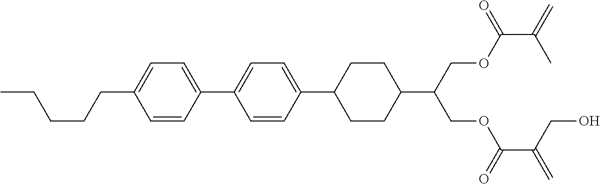 [SMILES: C=C(C)C(=O)OCC(COC(=O)C(=C)CO)C1CCC(c2ccc(-c3ccc(CCCCC)cc3)cc2)CC1] |
| 1ϵ-9-27 | 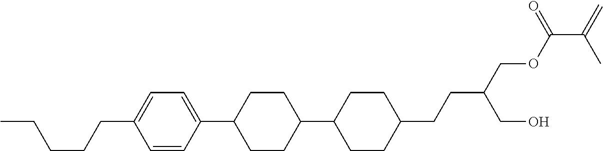 [SMILES: C=C(C)C(=O)OCC(CO)CCC1CCC(C2CCC(c3ccc(CCCCC)cc3)CC2)CC1] |
| 1ϵ-9-28 | 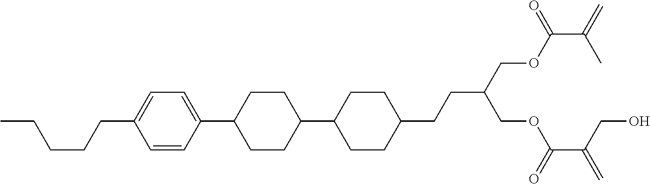 [SMILES: C=C(C)C(=O)OCC(CCC1CCC(C2CCC(c3ccc(CCCCC)cc3)CC2)CC1)COC(=O)C(=C)CO] |
| 1ϵ-9-29 | 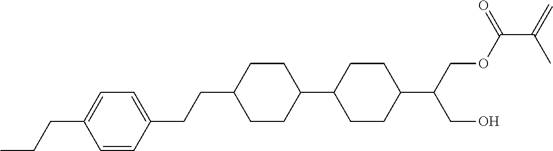 [SMILES: C=C(C)C(=O)OCC(CO)C1CCC(C2CCC(CCc3ccc(CCC)cc3)CC2)CC1] |
| 1ϵ-9-30 | 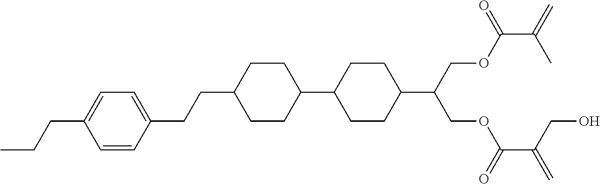 [SMILES: C=C(C)C(=O)OCC(COC(=O)C(=C)CO)C1CCC(C2CCC(CCc3ccc(CCC)cc3)CC2)CC1] |
| 1ϵ-9-31 | 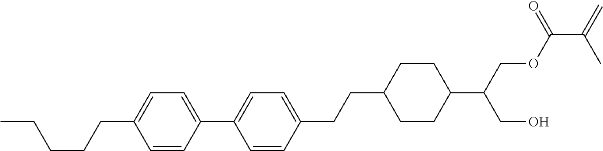 [SMILES: C=C(C)C(=O)OCC(CO)C1CCC(CCc2ccc(-c3ccc(CCCCC)cc3)cc2)CC1] |
| 1ϵ-9-32 | 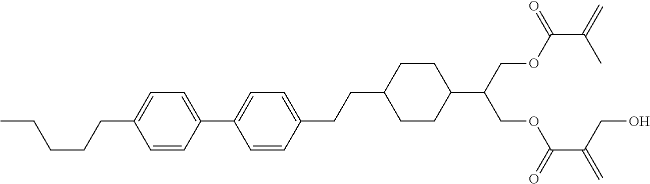 [SMILES: C=C(C)C(=O)OCC(COC(=O)C(=C)CO)C1CCC(CCc2ccc(-c3ccc(CCCCC)cc3)cc2)CC1] |
| 1ϵ-9-33 | 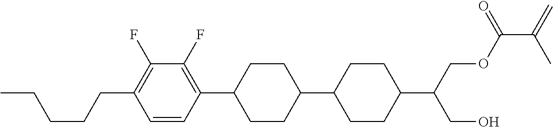 [SMILES: C=C(C)C(=O)OCC(CO)C1CCC(C2CCC(c3ccc(CCCCC)c(F)c3F)CC2)CC1] |
| 1ϵ-9-34 | 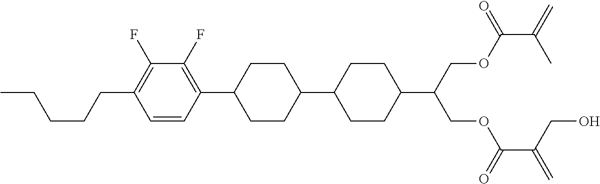 [SMILES: C=C(C)C(=O)OCC(COC(=O)C(=C)CO)C1CCC(C2CCC(c3ccc(CCCCC)c(F)c3F)CC2)CC1] |
| 1ϵ-9-35 | 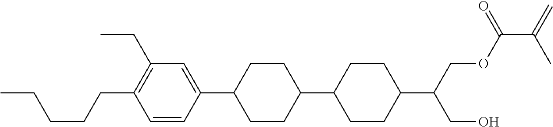 [SMILES: C=C(C)C(=O)OCC(CO)C1CCC(C2CCC(c3ccc(CCCCC)c(CC)c3)CC2)CC1] |
| 1ϵ-9-36 | 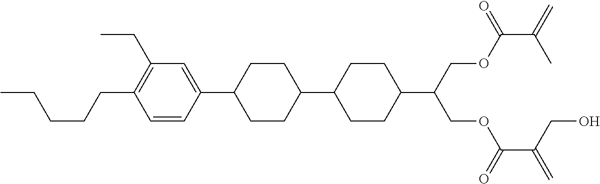 [SMILES: C=C(C)C(=O)OCC(COC(=O)C(=C)CO)C1CCC(C2CCC(c3ccc(CCCCC)c(CC)c3)CC2)CC1] |
| 1ϵ-9-37 | 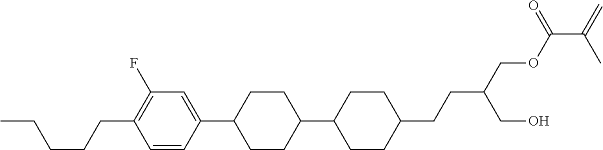 [SMILES: C=C(C)C(=O)OCC(CO)CCC1CCC(C2CCC(c3ccc(CCCCC)c(F)c3)CC2)CC1] |
| 1ϵ-9-38 | 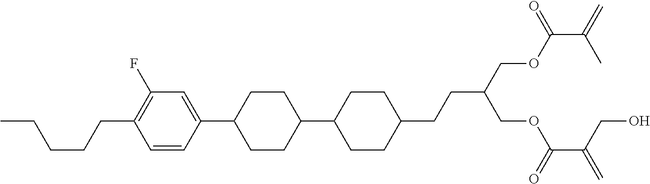 [SMILES: C=C(C)C(=O)OCC(CCC1CCC(C2CCC(c3ccc(CCCCC)c(F)c3)CC2)CC1)COC(=O)C(=C)CO] |
| 1ϵ-9-39 | 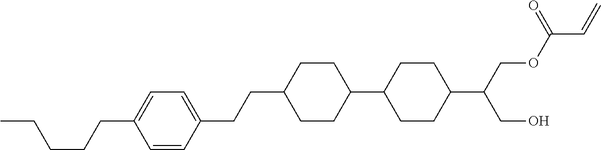 [SMILES: C=CC(=O)OCC(CO)C1CCC(C2CCC(CCc3ccc(CCCCC)cc3)CC2)CC1] |
| 1ϵ-9-40 | 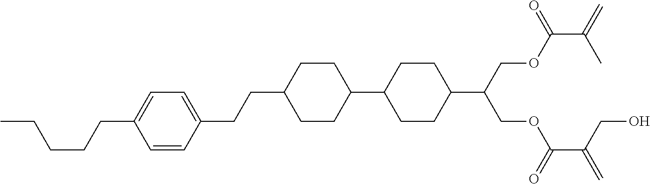 [SMILES: C=C(C)C(=O)OCC(COC(=O)C(=C)CO)C1CCC(C2CCC(CCc3ccc(CCCCC)cc3)CC2)CC1] |
| 1ϵ-10-1 | 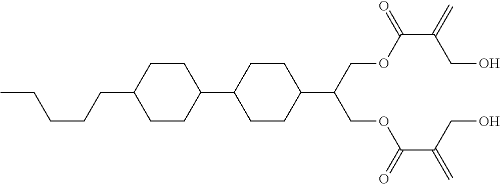 [SMILES: C=C(CO)C(=O)OCC(COC(=O)C(=C)CO)C1CCC(C2CCC(CCCCC)CC2)CC1] |
| 1ϵ-10-2 | 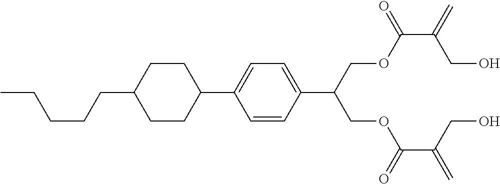 [SMILES: C=C(CO)C(=O)OCC(COC(=O)C(=C)CO)c1ccc(C2CCC(CCCCC)CC2)cc1] |
| 1ϵ-10-3 | 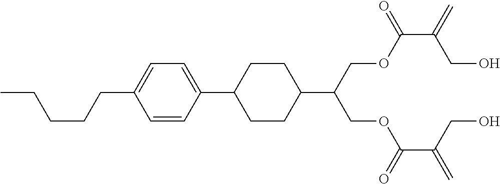 [SMILES: C=C(CO)C(=O)OCC(COC(=O)C(=C)CO)C1CCC(c2ccc(CCCCC)cc2)CC1] |
| 1ϵ-10-4 | 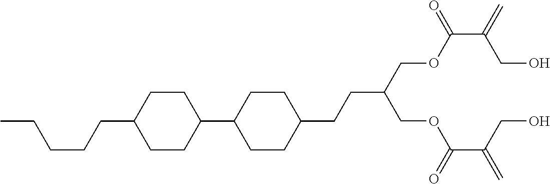 [SMILES: C=C(CO)C(=O)OCC(CCC1CCC(C2CCC(CCCCC)CC2)CC1)COC(=O)C(=C)CO] |
| 1ϵ-10-5 | 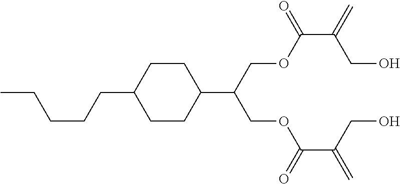 [SMILES: C=C(CO)C(=O)OCC(COC(=O)C(=C)CO)C1CCC(CCCCC)CC1] |
| 1ϵ-10-6 | 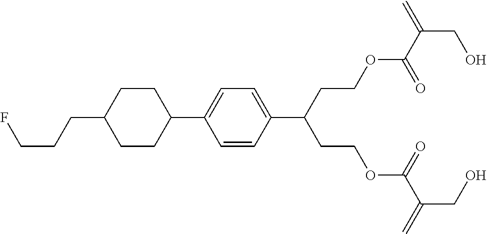 [SMILES: C=C(CO)C(=O)OCCC(CCOC(=O)C(=C)CO)c1ccc(C2CCC(CCCF)CC2)cc1] |
| 1ϵ-10-7 | 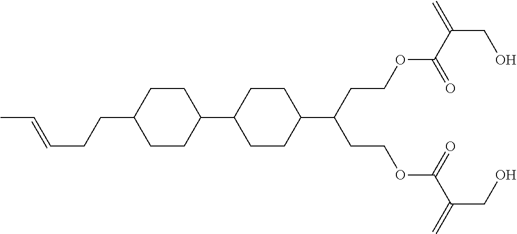 [SMILES: C=C(CO)C(=O)OCCC(CCOC(=O)C(=C)CO)C1CCC(C2CCC(CC/C=C/C)CC2)CC1] |
| 1ϵ-10-8 | 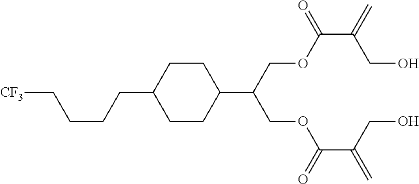 [SMILES: C=C(CO)C(=O)OCC(COC(=O)C(=C)CO)C1CCC(CCCCC(F)(F)F)CC1] |
| 1ϵ-10-9 | 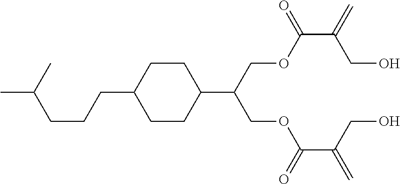 [SMILES: C=C(CO)C(=O)OCC(COC(=O)C(=C)CO)C1CCC(CCCC(C)C)CC1] |
| 1ϵ-10-10 | 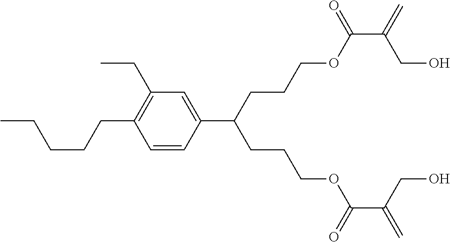 [SMILES: C=C(CO)C(=O)OCCCC(CCCOC(=O)C(=C)CO)c1ccc(CCCCC)c(CC)c1] |
| 1ϵ-10-11 | 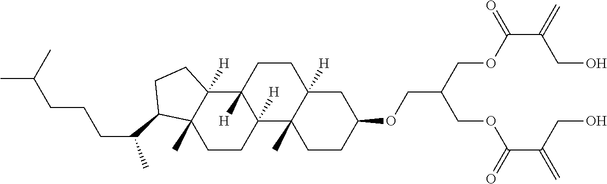 |
| 1ϵ-10-12 | 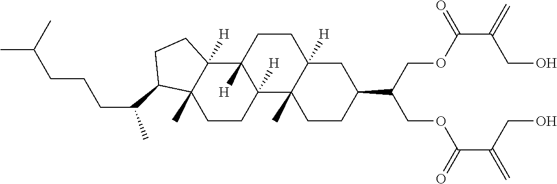 |
| 1ϵ-10-13 | 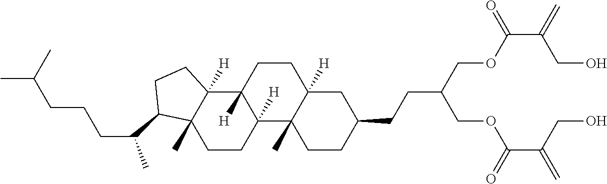 |
| 1ϵ-10-14 | 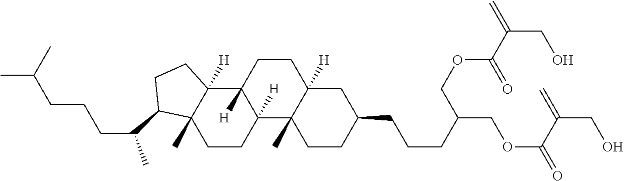 |
| 1ϵ-10-15 | 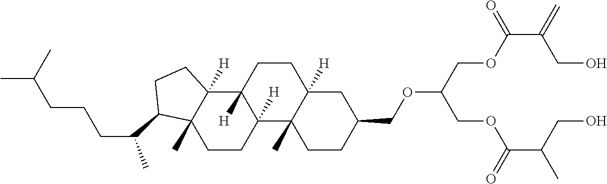 |
| 1ϵ-10-16 | 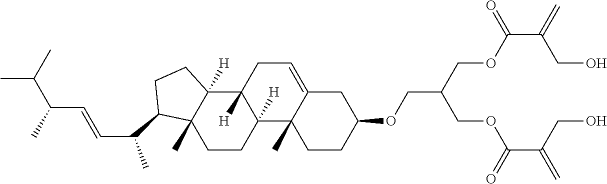 |
| 1ϵ-10-17 | 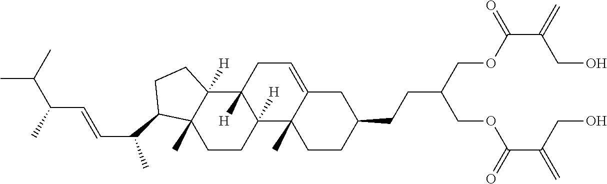 |
| 1ϵ-10-18 | 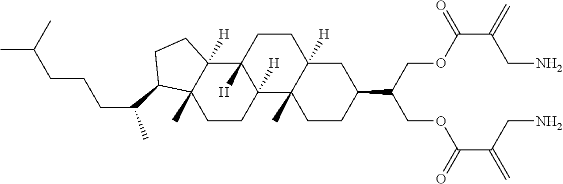 |
| 1ϵ-10-19 | 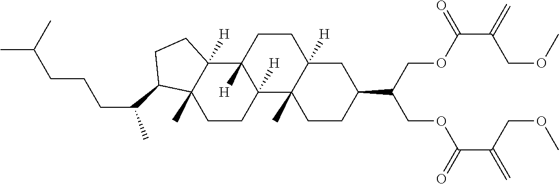 |
| 1ϵ-10-20 | 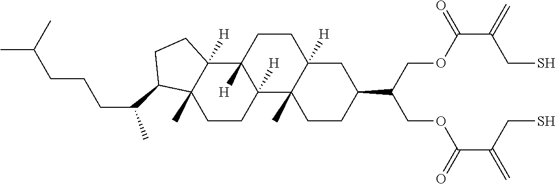 |
| 1ϵ-10-21 | 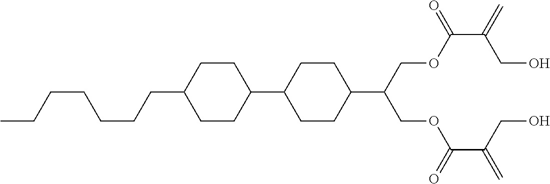 [SMILES: C=C(CO)C(=O)OCC(COC(=O)C(=C)CO)C1CCC(C2CCC(CCCCCCC)CC2)CC1] |
| 1ϵ-10-22 | 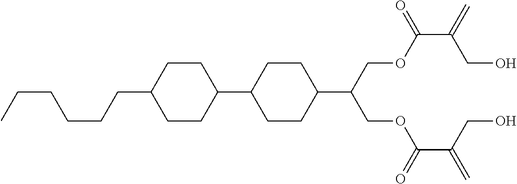 [SMILES: C=C(CO)C(=O)OCC(COC(=O)C(=C)CO)C1CCC(C2CCC(CCCCCC)CC2)CC1] |
| 1ϵ-10-23 | 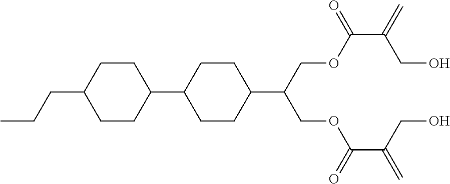 [SMILES: C=C(CO)C(=O)OCC(COC(=O)C(=C)CO)C1CCC(C2CCC(CCC)CC2)CC1] |
| 1ϵ-10-24 | 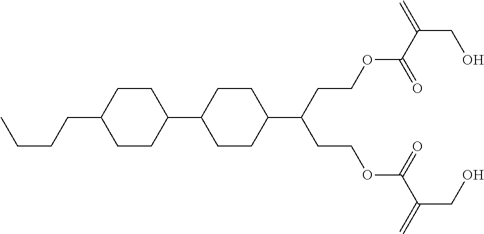 [SMILES: C=C(CO)C(=O)OCCC(CCOC(=O)C(=C)CO)C1CCC(C2CCC(CCCC)CC2)CC1] |
| 1ϵ-10-25 | 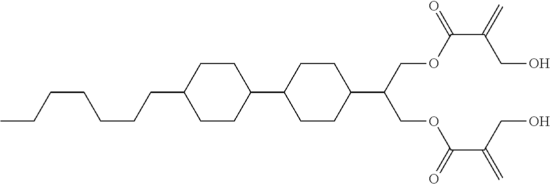 [SMILES: C=C(CO)C(=O)OCC(COC(=O)C(=C)CO)C1CCC(C2CCC(CCCCCCC)CC2)CC1] |
| 1ϵ-10-26 | 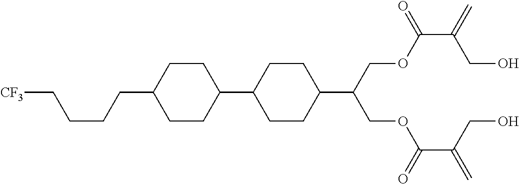 [SMILES: C=C(CO)C(=O)OCC(COC(=O)C(=C)CO)C1CCC(C2CCC(CCCCC(F)(F)F)CC2)CC1] |
| 1ϵ-10-27 | 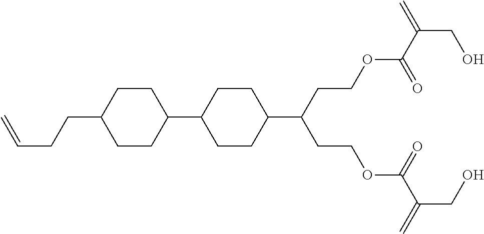 [SMILES: C=CCCC1CCC(C2CCC(C(CCOC(=O)C(=C)CO)CCOC(=O)C(=C)CO)CC2)CC1] |
| 1ϵ-10-28 | 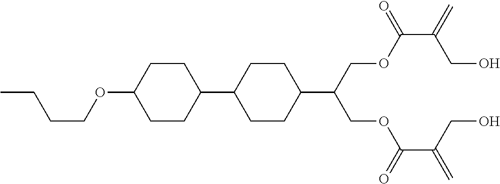 [SMILES: C=C(CO)C(=O)OCC(COC(=O)C(=C)CO)C1CCC(C2CCC(OCCCC)CC2)CC1] |
| 1ϵ-10-29 | 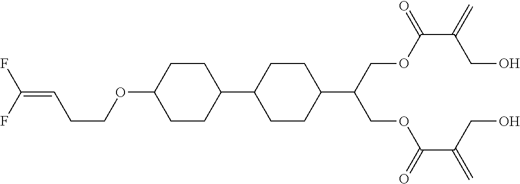 [SMILES: C=C(CO)C(=O)OCC(COC(=O)C(=C)CO)C1CCC(C2CCC(OCCC=C(F)F)CC2)CC1] |
| 1ϵ-10-30 | 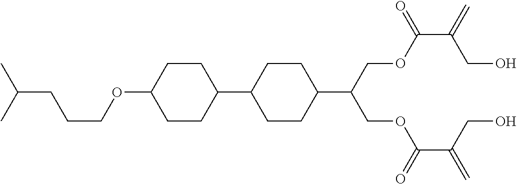 [SMILES: C=C(CO)C(=O)OCC(COC(=O)C(=C)CO)C1CCC(C2CCC(OCCCC(C)C)CC2)CC1] |
| 1ϵ-10-31 | 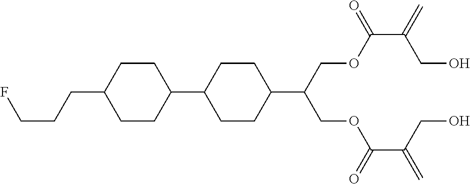 [SMILES: C=C(CO)C(=O)OCC(COC(=O)C(=C)CO)C1CCC(C2CCC(CCCF)CC2)CC1] |
| 1ϵ-10-32 | 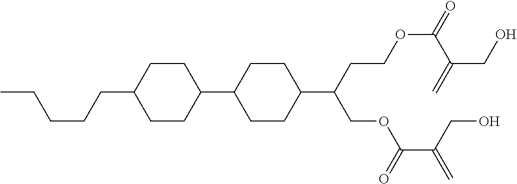 [SMILES: C=C(CO)C(=O)OCCC(COC(=O)C(=C)CO)C1CCC(C2CCC(CCCCC)CC2)CC1] |
| 1ϵ-10-33 | 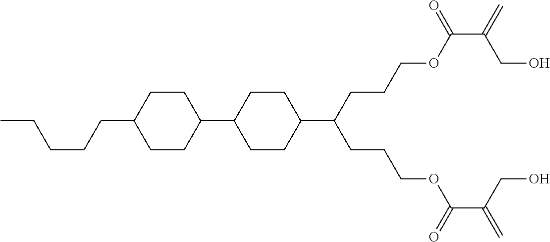 [SMILES: C=C(CO)C(=O)OCCCC(CCCOC(=O)C(=C)CO)C1CCC(C2CCC(CCCCC)CC2)CC1] |
| 1ϵ-10-34 | 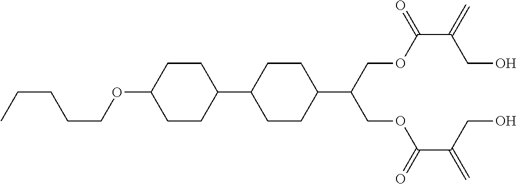 [SMILES: C=C(CO)C(=O)OCC(COC(=O)C(=C)CO)C1CCC(C2CCC(OCCCCC)CC2)CC1] |
| 1ϵ-10-35 | 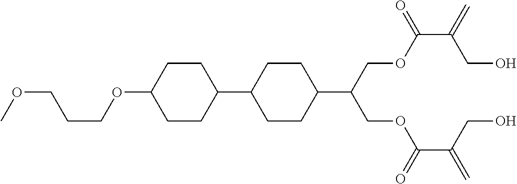 [SMILES: C=C(CO)C(=O)OCC(COC(=O)C(=C)CO)C1CCC(C2CCC(OCCCOC)CC2)CC1] |
| 1ϵ-10-36 | 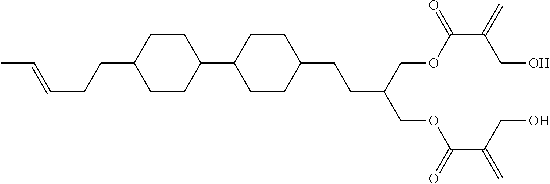 [SMILES: C=C(CO)C(=O)OCC(CCC1CCC(C2CCC(CC/C=C/C)CC2)CC1)COC(=O)C(=C)CO] |
| 1ϵ-10-37 | 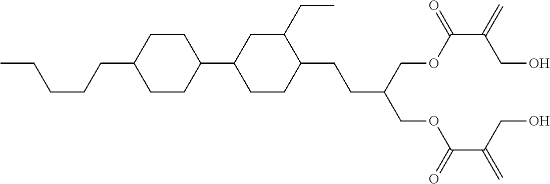 [SMILES: C=C(CO)C(=O)OCC(CCC1CCC(C2CCC(CCCCC)CC2)CC1CC)COC(=O)C(=C)CO] |
| 1ϵ-10-38 | 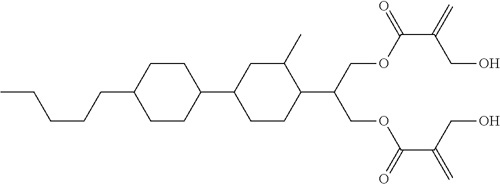 [SMILES: C=C(CO)C(=O)OCC(COC(=O)C(=C)CO)C1CCC(C2CCC(CCCCC)CC2)CC1C] |
| 1ϵ-10-39 | 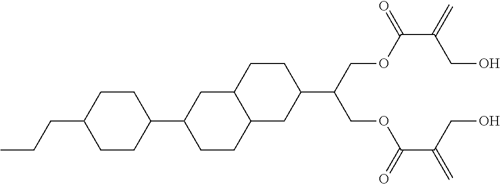 [SMILES: C=C(CO)C(=O)OCC(COC(=O)C(=C)CO)C1CCC2CC(C3CCC(CCC)CC3)CCC2C1] |
| 1ϵ-10-40 | 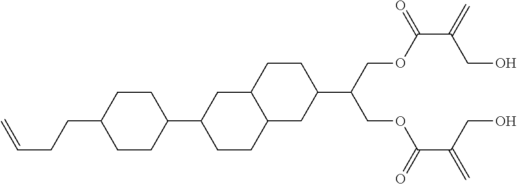 [SMILES: C=CCCC1CCC(C2CCC3CC(C(COC(=O)C(=C)CO)COC(=O)C(=C)CO)CCC3C2)CC1] |
| 1ϵ-10-41 | 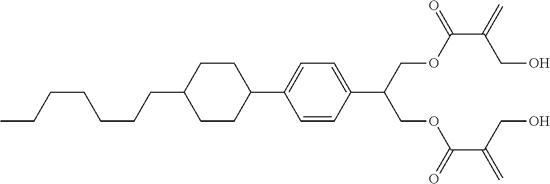 [SMILES: C=C(CO)C(=O)OCC(COC(=O)C(=C)CO)c1ccc(C2CCC(CCCCCCC)CC2)cc1] |
| 1ϵ-10-42 | 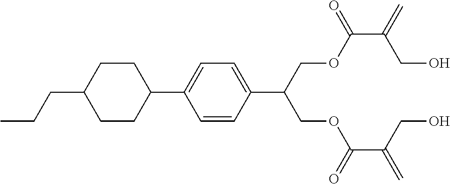 [SMILES: C=C(CO)C(=O)OCC(COC(=O)C(=C)CO)c1ccc(C2CCC(CCC)CC2)cc1] |
| 1ϵ-10-43 | 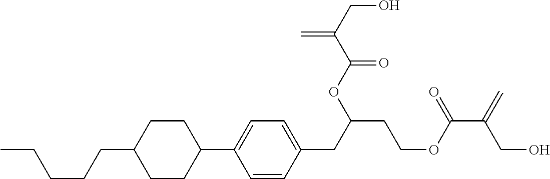 [SMILES: C=C(CO)C(=O)OCCC(Cc1ccc(C2CCC(CCCCC)CC2)cc1)OC(=O)C(=C)CO] |
| 1ϵ-10-44 | 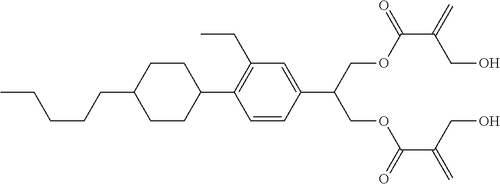 [SMILES: C=C(CO)C(=O)OCC(COC(=O)C(=C)CO)c1ccc(C2CCC(CCCCC)CC2)c(CC)c1] |
| 1ϵ-10-45 | 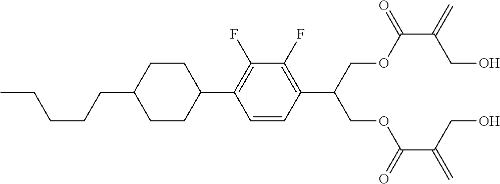 [SMILES: C=C(CO)C(=O)OCC(COC(=O)C(=C)CO)c1ccc(C2CCC(CCCCC)CC2)c(F)c1F] |
| 1ϵ-10-46 | 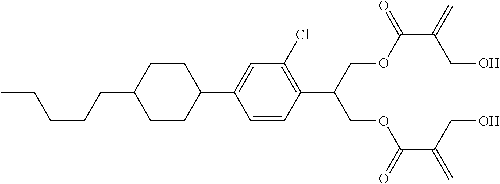 [SMILES: C=C(CO)C(=O)OCC(COC(=O)C(=C)CO)c1ccc(C2CCC(CCCCC)CC2)cc1Cl] |
| 1ϵ-10-47 | 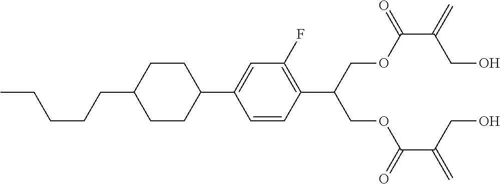 [SMILES: C=C(CO)C(=O)OCC(COC(=O)C(=C)CO)c1ccc(C2CCC(CCCCC)CC2)cc1F] |
| 1ϵ-10-48 | 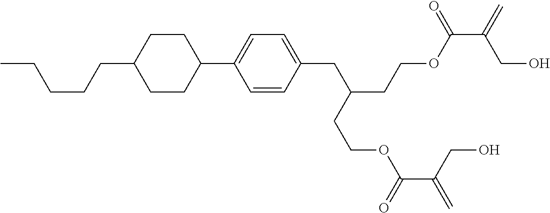 [SMILES: C=C(CO)C(=O)OCCC(CCOC(=O)C(=C)CO)Cc1ccc(C2CCC(CCCCC)CC2)cc1] |
| 1ϵ-10-49 | 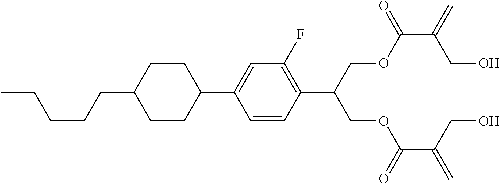 [SMILES: C=C(CO)C(=O)OCC(COC(=O)C(=C)CO)c1ccc(C2CCC(CCCCC)CC2)cc1F] |
| 1ϵ-10-50 | 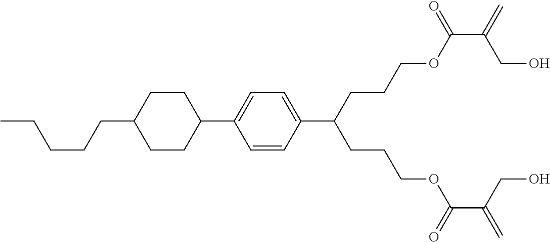 [SMILES: C=C(CO)C(=O)OCCCC(CCCOC(=O)C(=C)CO)c1ccc(C2CCC(CCCCC)CC2)cc1] |
| 1ϵ-10-51 | 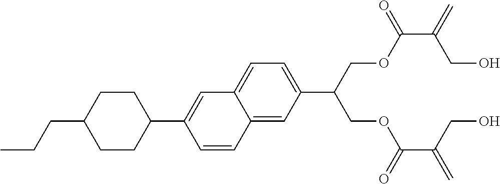 [SMILES: C=C(CO)C(=O)OCC(COC(=O)C(=C)CO)c1ccc2cc(C3CCC(CCC)CC3)ccc2c1] |
| 1ϵ-10-52 | 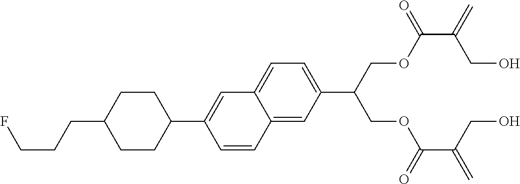 [SMILES: C=C(CO)C(=O)OCC(COC(=O)C(=C)CO)c1ccc2cc(C3CCC(CCCF)CC3)ccc2c1] |
| 1ϵ-10-53 | 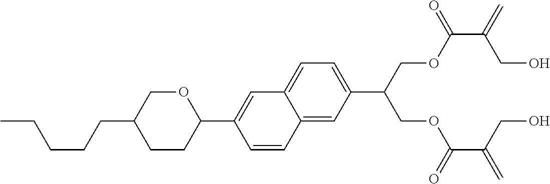 [SMILES: C=C(CO)C(=O)OCC(COC(=O)C(=C)CO)c1ccc2cc(C3CCC(CCCCC)CO3)ccc2c1] |
| 1ϵ-10-54 | 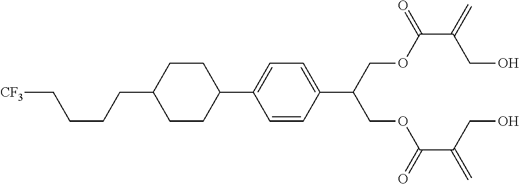 [SMILES: C=C(CO)C(=O)OCC(COC(=O)C(=C)CO)c1ccc(C2CCC(CCCCC(F)(F)F)CC2)cc1] |
| 1ϵ-10-55 | 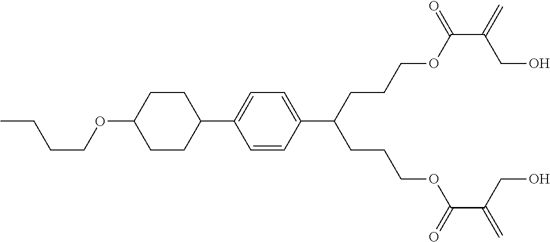 [SMILES: C=C(CO)C(=O)OCCCC(CCCOC(=O)C(=C)CO)c1ccc(C2CCC(OCCCC)CC2)cc1] |
| 1ϵ-10-56 | 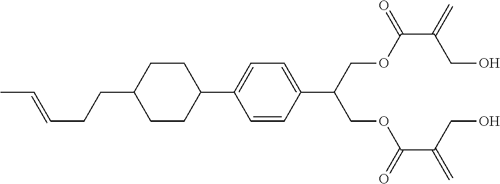 [SMILES: C=C(CO)C(=O)OCC(COC(=O)C(=C)CO)c1ccc(C2CCC(CC/C=C/C)CC2)cc1] |
| 1ϵ-10-57 | 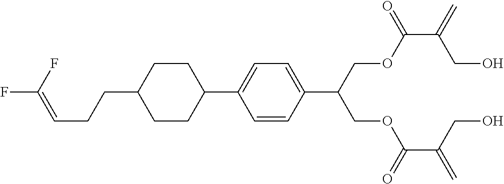 [SMILES: C=C(CO)C(=O)OCC(COC(=O)C(=C)CO)c1ccc(C2CCC(CCC=C(F)F)CC2)cc1] |
| 1ϵ-10-58 | 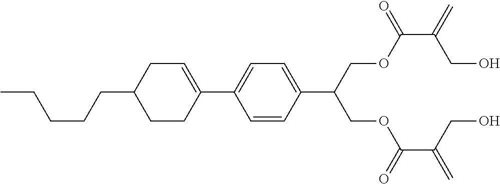 [SMILES: C=C(CO)C(=O)OCC(COC(=O)C(=C)CO)c1ccc(C2=CCC(CCCCC)CC2)cc1] |
| 1ϵ-10-59 | 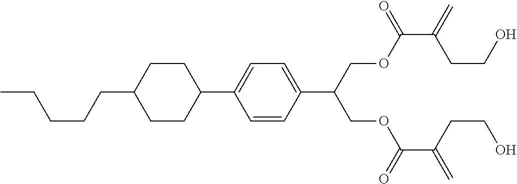 [SMILES: C=C(CCO)C(=O)OCC(COC(=O)C(=C)CCO)c1ccc(C2CCC(CCCCC)CC2)cc1] |
| 1ϵ-10-60 | 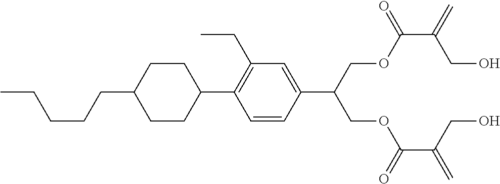 [SMILES: C=C(CO)C(=O)OCC(COC(=O)C(=C)CO)c1ccc(C2CCC(CCCCC)CC2)c(CC)c1] |
| 1ϵ-10-61 | 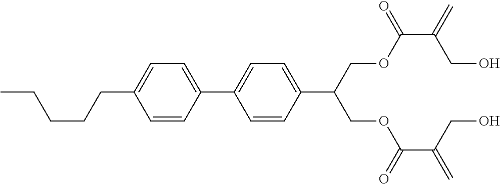 [SMILES: C=C(CO)C(=O)OCC(COC(=O)C(=C)CO)c1ccc(-c2ccc(CCCCC)cc2)cc1] |
| 1ϵ-10-62 | 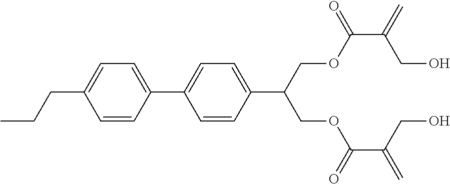 [SMILES: C=C(CO)C(=O)OCC(COC(=O)C(=C)CO)c1ccc(-c2ccc(CCC)cc2)cc1] |
| 1ϵ-10-63 | 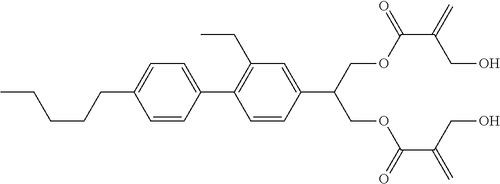 [SMILES: C=C(CO)C(=O)OCC(COC(=O)C(=C)CO)c1ccc(-c2ccc(CCCCC)cc2)c(CC)c1] |
| 1ϵ-10-64 | 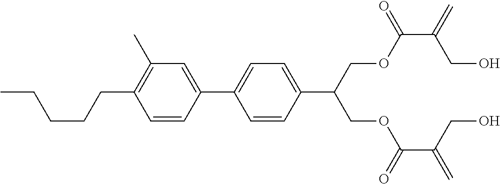 [SMILES: C=C(CO)C(=O)OCC(COC(=O)C(=C)CO)c1ccc(-c2ccc(CCCCC)c(C)c2)cc1] |
| 1ϵ-10-65 | 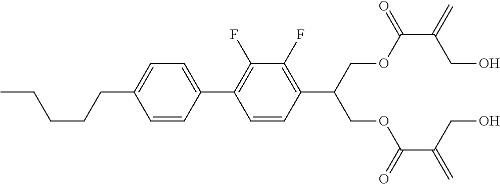 [SMILES: C=C(CO)C(=O)OCC(COC(=O)C(=C)CO)c1ccc(-c2ccc(CCCCC)cc2)c(F)c1F] |
| 1ϵ-10-66 | 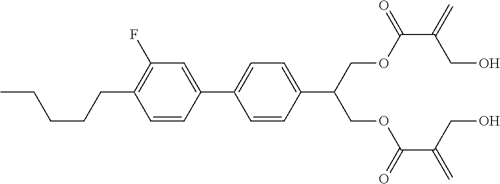 [SMILES: C=C(CO)C(=O)OCC(COC(=O)C(=C)CO)c1ccc(-c2ccc(CCCCC)c(F)c2)cc1] |
| 1ϵ-10-67 | 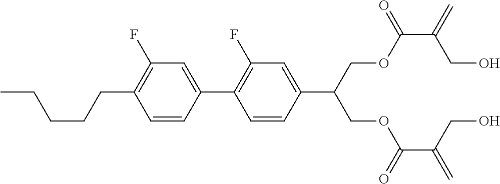 [SMILES: C=C(CO)C(=O)OCC(COC(=O)C(=C)CO)c1ccc(-c2ccc(CCCCC)c(F)c2)c(F)c1] |
| 1ϵ-10-68 | 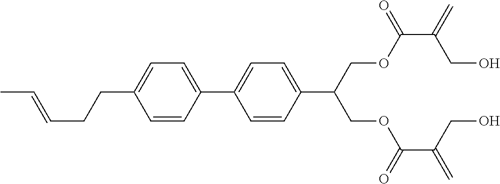 [SMILES: C=C(CO)C(=O)OCC(COC(=O)C(=C)CO)c1ccc(-c2ccc(CC/C=C/C)cc2)cc1] |
| 1ϵ-10-69 | 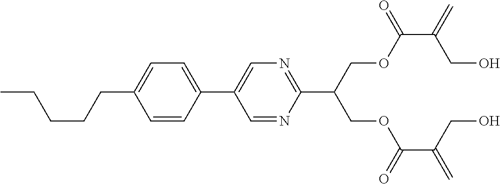 [SMILES: C=C(CO)C(=O)OCC(COC(=O)C(=C)CO)c1ncc(-c2ccc(CCCCC)cc2)cn1] |
| 1ϵ-10-70 | 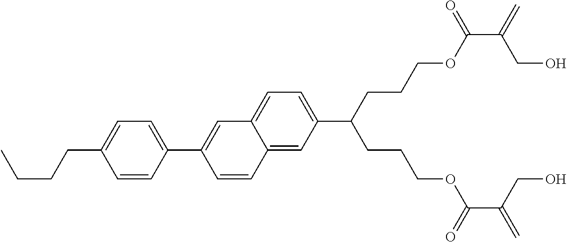 [SMILES: C=C(CO)C(=O)OCCCC(CCCOC(=O)C(=C)CO)c1ccc2cc(-c3ccc(CCCC)cc3)ccc2c1] |
| 1ϵ-10-71 | 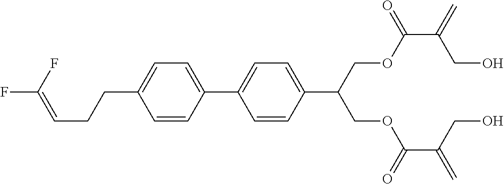 [SMILES: C=C(CO)C(=O)OCC(COC(=O)C(=C)CO)c1ccc(-c2ccc(CCC=C(F)F)cc2)cc1] |
| 1ϵ-10-72 | 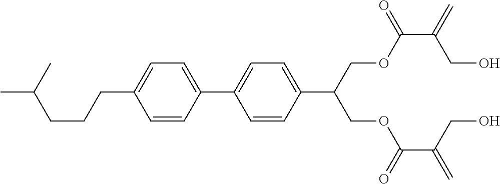 [SMILES: C=C(CO)C(=O)OCC(COC(=O)C(=C)CO)c1ccc(-c2ccc(CCCC(C)C)cc2)cc1] |
| 1ϵ-10-73 | 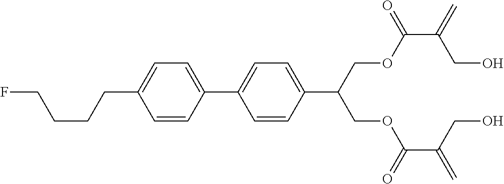 [SMILES: C=C(CO)C(=O)OCC(COC(=O)C(=C)CO)c1ccc(-c2ccc(CCCCF)cc2)cc1] |
| 1ϵ-10-74 | 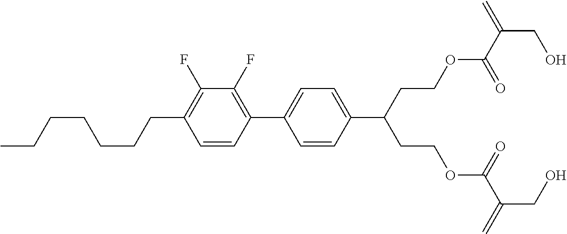 [SMILES: C=C(CO)C(=O)OCCC(CCOC(=O)C(=C)CO)c1ccc(-c2ccc(CCCCCCC)c(F)c2F)cc1] |
| 1ϵ-10-75 | 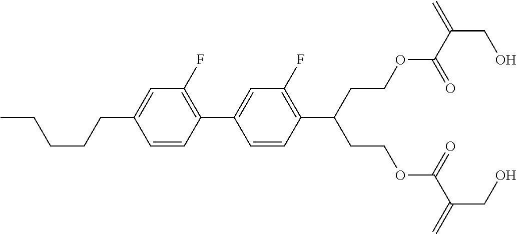 [SMILES: C=C(CO)C(=O)OCCC(CCOC(=O)C(=C)CO)c1ccc(-c2ccc(CCCCC)cc2F)cc1F] |
| 1ϵ-10-76 | 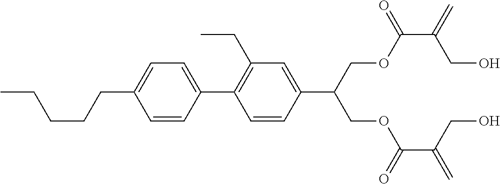 [SMILES: C=C(CO)C(=O)OCC(COC(=O)C(=C)CO)c1ccc(-c2ccc(CCCCC)cc2)c(CC)c1] |
| 1ϵ-10-77 | 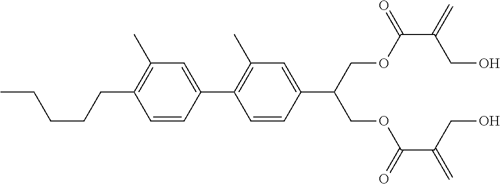 [SMILES: C=C(CO)C(=O)OCC(COC(=O)C(=C)CO)c1ccc(-c2ccc(CCCCC)c(C)c2)c(C)c1] |
| 1ϵ-10-78 | 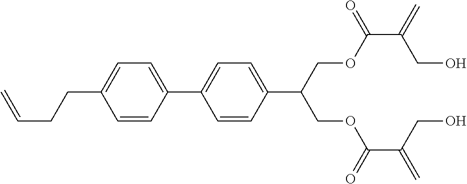 [SMILES: C=CCCc1ccc(-c2ccc(C(COC(=O)C(=C)CO)COC(=O)C(=C)CO)cc2)cc1] |
| 1ϵ-10-79 | 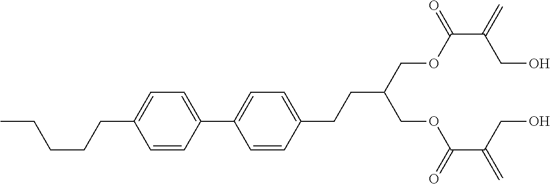 [SMILES: C=C(CO)C(=O)OCC(CCc1ccc(-c2ccc(CCCCC)cc2)cc1)COC(=O)C(=C)CO] |
| 1ϵ-10-80 | 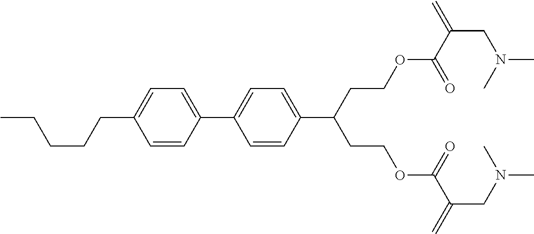 [SMILES: C=C(CN(C)C)C(=O)OCCC(CCOC(=O)C(=C)CN(C)C)c1ccc(-c2ccc(CCCCC)cc2)cc1] |
| 1ϵ-10-81 | 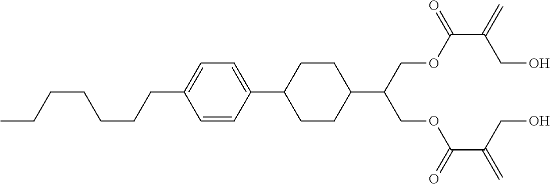 [SMILES: C=C(CO)C(=O)OCC(COC(=O)C(=C)CO)C1CCC(c2ccc(CCCCCCC)cc2)CC1] |
| 1ϵ-10-82 | 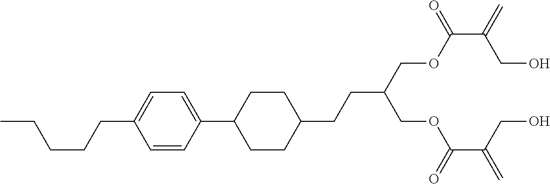 [SMILES: C=C(CO)C(=O)OCC(CCC1CCC(c2ccc(CCCCC)cc2)CC1)COC(=O)C(=C)CO] |
| 1ϵ-10-83 | 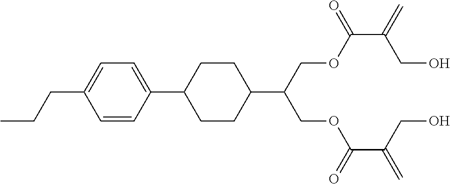 [SMILES: C=C(CO)C(=O)OCC(COC(=O)C(=C)CO)C1CCC(c2ccc(CCC)cc2)CC1] |
| 1ϵ-10-84 | 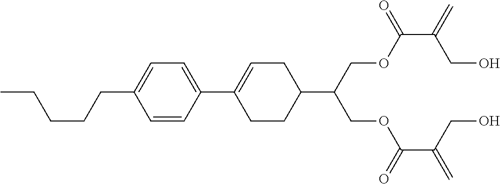 [SMILES: C=C(CO)C(=O)OCC(COC(=O)C(=C)CO)C1CC=C(c2ccc(CCCCC)cc2)CC1] |
| 1ϵ-10-85 | 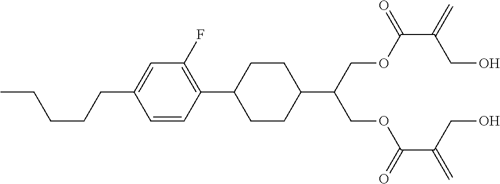 [SMILES: C=C(CO)C(=O)OCC(COC(=O)C(=C)CO)C1CCC(c2ccc(CCCCC)cc2F)CC1] |
| 1ϵ-10-86 | 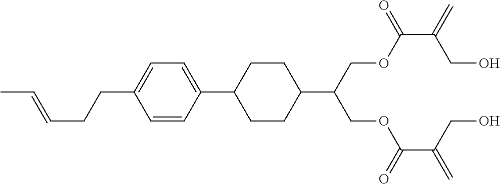 [SMILES: C=C(CO)C(=O)OCC(COC(=O)C(=C)CO)C1CCC(c2ccc(CC/C=C/C)cc2)CC1] |
| 1ϵ-10-87 | 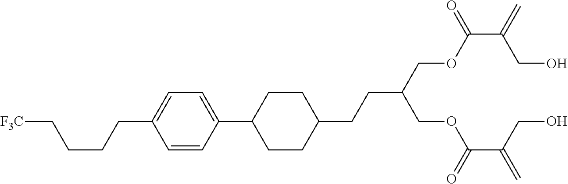 [SMILES: C=C(CO)C(=O)OCC(CCC1CCC(c2ccc(CCCCC(F)(F)F)cc2)CC1)COC(=O)C(=C)CO] |
| 1ϵ-10-88 | 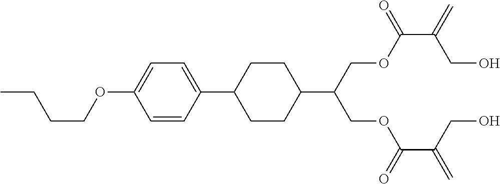 [SMILES: C=C(CO)C(=O)OCC(COC(=O)C(=C)CO)C1CCC(c2ccc(OCCCC)cc2)CC1] |
| 1ϵ-10-89 | 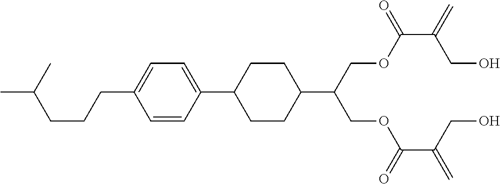 [SMILES: C=C(CO)C(=O)OCC(COC(=O)C(=C)CO)C1CCC(c2ccc(CCCC(C)C)cc2)CC1] |
| 1ϵ-10-90 | 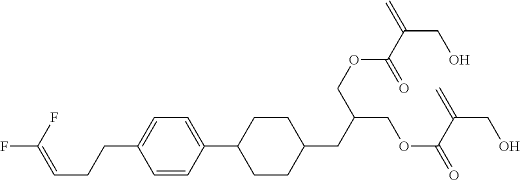 [SMILES: C=C(CO)C(=O)OCC(COC(=O)C(=C)CO)CC1CCC(c2ccc(CCC=C(F)F)cc2)CC1] |
| 1ϵ-10-91 | 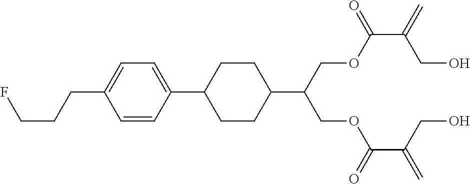 [SMILES: C=C(CO)C(=O)OCC(COC(=O)C(=C)CO)C1CCC(c2ccc(CCCF)cc2)CC1] |
| 1ϵ-10-92 | 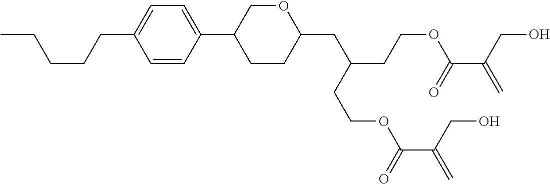 [SMILES: C=C(CO)C(=O)OCCC(CCOC(=O)C(=C)CO)CC1CCC(c2ccc(CCCCC)cc2)CO1] |
| 1ϵ-10-93 | 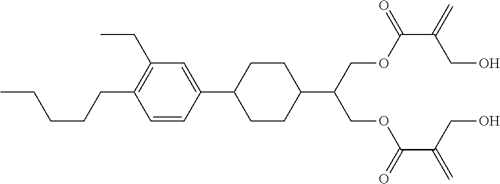 [SMILES: C=C(CO)C(=O)OCC(COC(=O)C(=C)CO)C1CCC(c2ccc(CCCCC)c(CC)c2)CC1] |
| 1ϵ-10-94 | 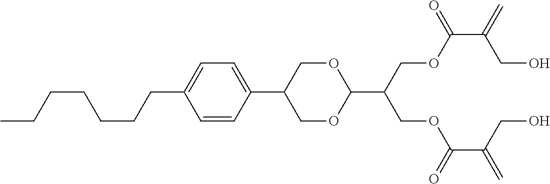 [SMILES: C=C(CO)C(=O)OCC(COC(=O)C(=C)CO)C1OCC(c2ccc(CCCCCCC)cc2)CO1] |
| 1ϵ-10-95 | 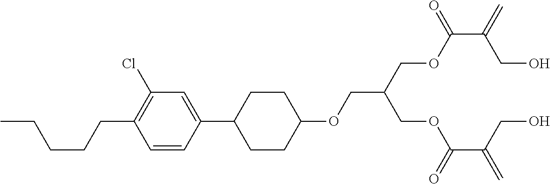 [SMILES: C=C(CO)C(=O)OCC(COC(=O)C(=C)CO)COC1CCC(c2ccc(CCCCC)c(Cl)c2)CC1] |
| 1ϵ-10-96 | 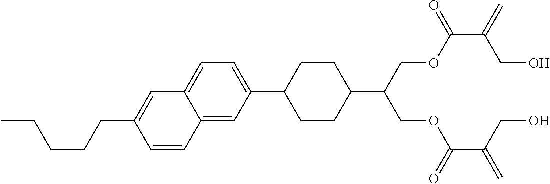 [SMILES: C=C(CO)C(=O)OCC(COC(=O)C(=C)CO)C1CCC(c2ccc3cc(CCCCC)ccc3c2)CC1] |
| 1ϵ-10-97 | 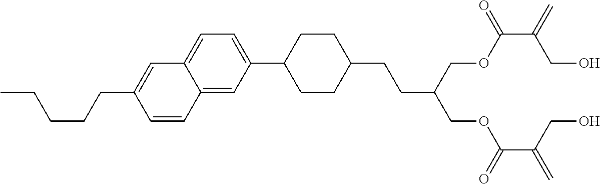 [SMILES: C=C(CO)C(=O)OCC(CCC1CCC(c2ccc3cc(CCCCC)ccc3c2)CC1)COC(=O)C(=C)CO] |
| 1ϵ-10-98 | 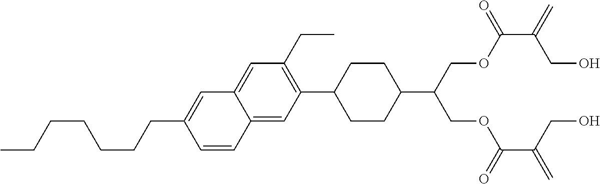 [SMILES: C=C(CO)C(=O)OCC(COC(=O)C(=C)CO)C1CCC(c2cc3ccc(CCCCCCC)cc3cc2CC)CC1] |
| 1ϵ-10-99 | 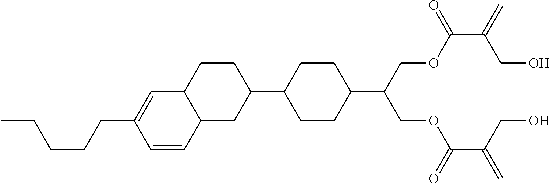 [SMILES: C=C(CO)C(=O)OCC(COC(=O)C(=C)CO)C1CCC(C2CCC3C=C(CCCCC)C=CC3C2)CC1] |
| 1ϵ-10-100 | 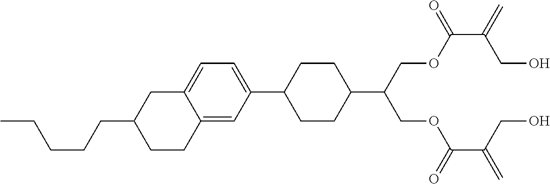 [SMILES: C=C(CO)C(=O)OCC(COC(=O)C(=C)CO)C1CCC(c2ccc3c(c2)CCC(CCCCC)C3)CC1] |
| 1ϵ-10-101 | 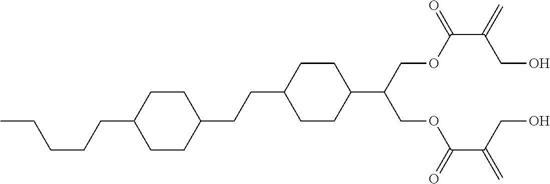 [SMILES: C=C(CO)C(=O)OCC(COC(=O)C(=C)CO)C1CCC(CCC2CCC(CCCCC)CC2)CC1] |
| 1ϵ-10-102 | 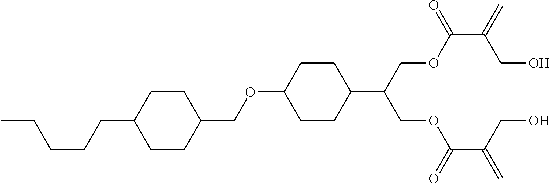 [SMILES: C=C(CO)C(=O)OCC(COC(=O)C(=C)CO)C1CCC(OCC2CCC(CCCCC)CC2)CC1] |
| 1ϵ-10-103 | 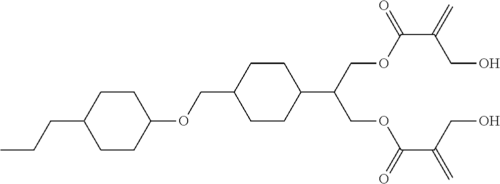 [SMILES: C=C(CO)C(=O)OCC(COC(=O)C(=C)CO)C1CCC(COC2CCC(CCC)CC2)CC1] |
| 1ϵ-10-104 | 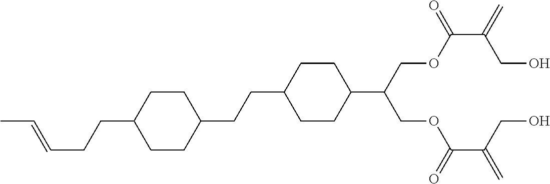 [SMILES: C=C(CO)C(=O)OCC(COC(=O)C(=C)CO)C1CCC(CCC2CCC(CC/C=C/C)CC2)CC1] |
| 1ϵ-10-105 | 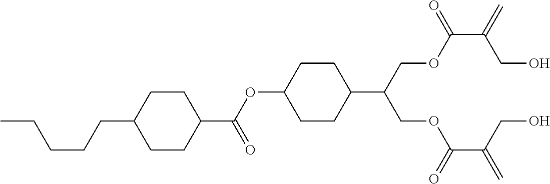 [SMILES: C=C(CO)C(=O)OCC(COC(=O)C(=C)CO)C1CCC(OC(=O)C2CCC(CCCCC)CC2)CC1] |
| 1ϵ-10-106 | 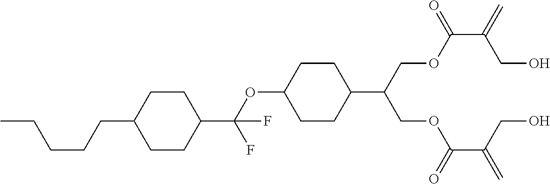 [SMILES: C=C(CO)C(=O)OCC(COC(=O)C(=C)CO)C1CCC(OC(F)(F)C2CCC(CCCCC)CC2)CC1] |
| 1ϵ-10-107 | 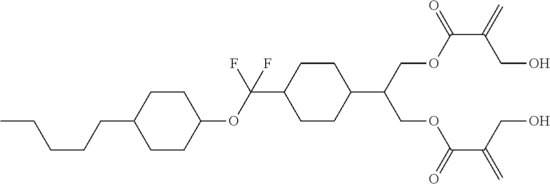 [SMILES: C=C(CO)C(=O)OCC(COC(=O)C(=C)CO)C1CCC(C(F)(F)OC2CCC(CCCCC)CC2)CC1] |
| 1ϵ-10-108 | 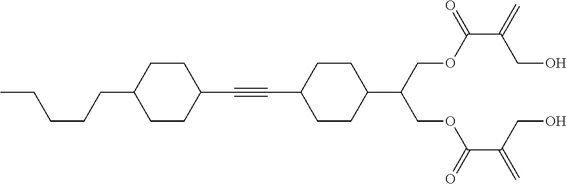 [SMILES: C=C(CO)C(=O)OCC(COC(=O)C(=C)CO)C1CCC(C#CC2CCC(CCCCC)CC2)CC1] |
| 1ϵ-10-109 | 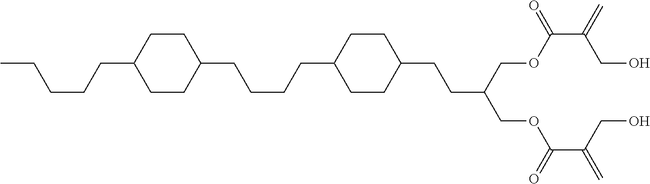 [SMILES: C=C(CO)C(=O)OCC(CCC1CCC(CCCCC2CCC(CCCCC)CC2)CC1)COC(=O)C(=C)CO] |
| 1ϵ-10-110 | 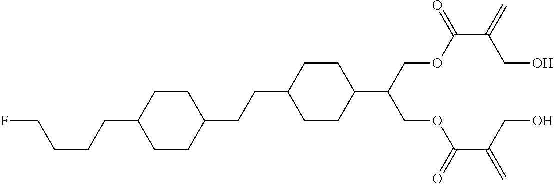 [SMILES: C=C(CO)C(=O)OCC(COC(=O)C(=C)CO)C1CCC(CCC2CCC(CCCCF)CC2)CC1] |
| 1ϵ-10-111 | 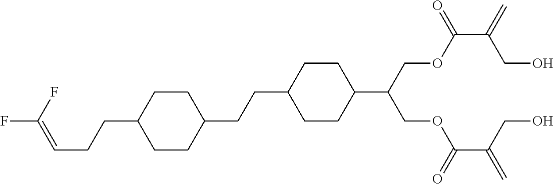 [SMILES: C=C(CO)C(=O)OCC(COC(=O)C(=C)CO)C1CCC(CCC2CCC(CCC=C(F)F)CC2)CC1] |
| 1ϵ-10-112 | 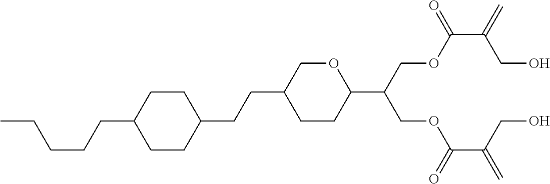 [SMILES: C=C(CO)C(=O)OCC(COC(=O)C(=C)CO)C1CCC(CCC2CCC(CCCCC)CC2)CO1] |
| 1ϵ-10-113 | 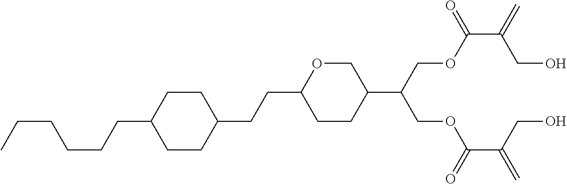 [SMILES: C=C(CO)C(=O)OCC(COC(=O)C(=C)CO)C1CCC(CCC2CCC(CCCCCC)CC2)OC1] |
| 1ϵ-10-114 | 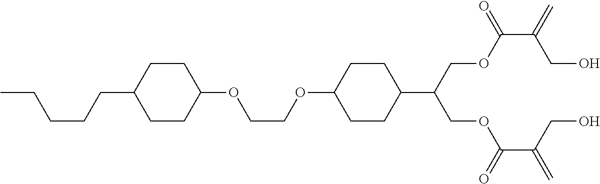 [SMILES: C=C(CO)C(=O)OCC(COC(=O)C(=C)CO)C1CCC(OCCOC2CCC(CCCCC)CC2)CC1] |
| 1ϵ-10-115 | 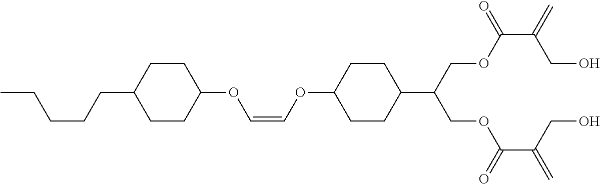 [SMILES: C=C(CO)C(=O)OCC(COC(=O)C(=C)CO)C1CCC(O/C=C\OC2CCC(CCCCC)CC2)CC1] |
| 1ϵ-10-116 | 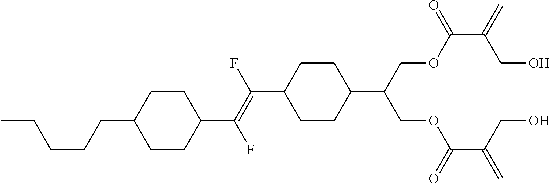 [SMILES: C=C(CO)C(=O)OCC(COC(=O)C(=C)CO)C1CCC(/C(F)=C(\F)C2CCC(CCCCC)CC2)CC1] |
| 1ϵ-10-117 | 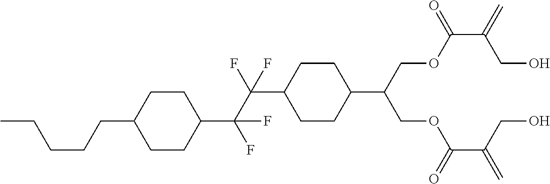 [SMILES: C=C(CO)C(=O)OCC(COC(=O)C(=C)CO)C1CCC(C(F)(F)C(F)(F)C2CCC(CCCCC)CC2)CC1] |
| 1ϵ-10-118 | 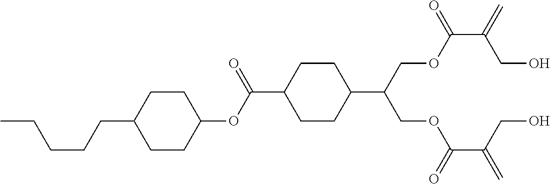 [SMILES: C=C(CO)C(=O)OCC(COC(=O)C(=C)CO)C1CCC(C(=O)OC2CCC(CCCCC)CC2)CC1] |
| 1ϵ-10-119 | 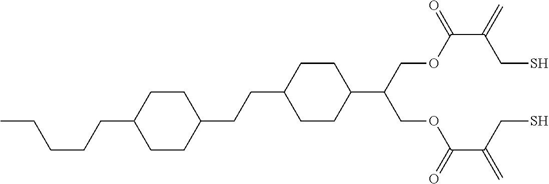 [SMILES: C=C(CS)C(=O)OCC(COC(=O)C(=C)CS)C1CCC(CCC2CCC(CCCCC)CC2)CC1] |
| 1ϵ-10-120 | 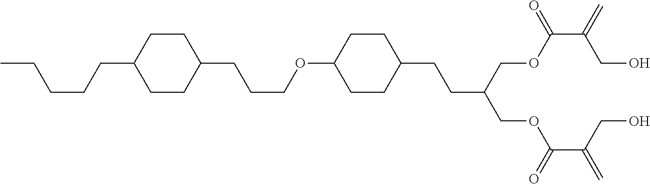 [SMILES: C=C(CO)C(=O)OCC(CCC1CCC(OCCCC2CCC(CCCCC)CC2)CC1)COC(=O)C(=C)CO] |
| 1ϵ-10-121 | 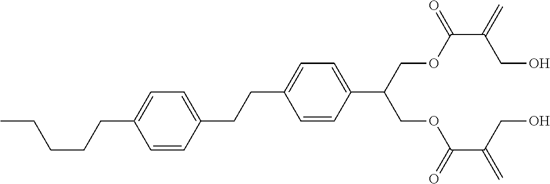 [SMILES: C=C(CO)C(=O)OCC(COC(=O)C(=C)CO)c1ccc(CCc2ccc(CCCCC)cc2)cc1] |
| 1ϵ-10-122 | 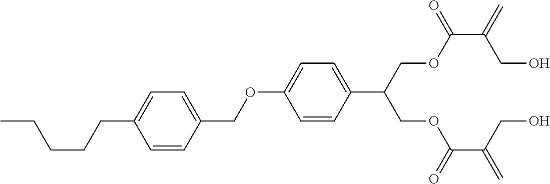 [SMILES: C=C(CO)C(=O)OCC(COC(=O)C(=C)CO)c1ccc(OCc2ccc(CCCCC)cc2)cc1] |
| 1ϵ-10-123 | 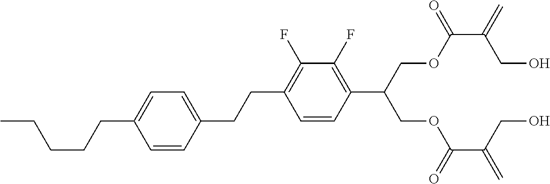 [SMILES: C=C(CO)C(=O)OCC(COC(=O)C(=C)CO)c1ccc(CCc2ccc(CCCCC)cc2)c(F)c1F] |
| 1ϵ-10-124 | 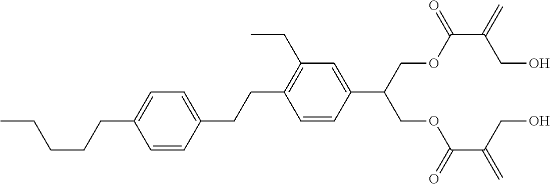 [SMILES: C=C(CO)C(=O)OCC(COC(=O)C(=C)CO)c1ccc(CCc2ccc(CCCCC)cc2)c(CC)c1] |
| 1ϵ-10-125 | 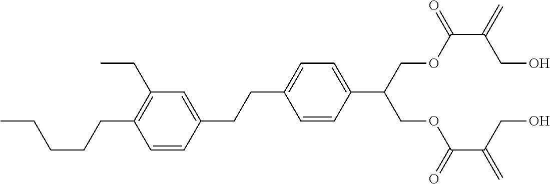 [SMILES: C=C(CO)C(=O)OCC(COC(=O)C(=C)CO)c1ccc(CCc2ccc(CCCCC)c(CC)c2)cc1] |
| 1ϵ-10-126 | 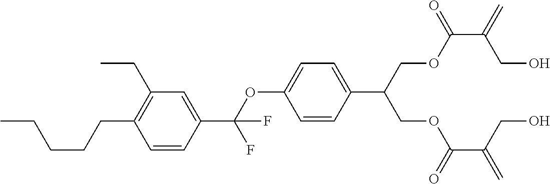 [SMILES: C=C(CO)C(=O)OCC(COC(=O)C(=C)CO)c1ccc(OC(F)(F)c2ccc(CCCCC)c(CC)c2)cc1] |
| 1ϵ-10-127 | 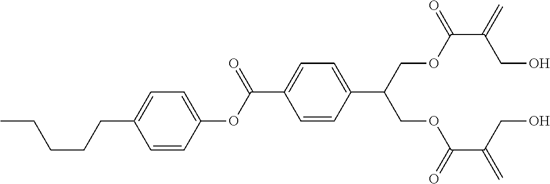 [SMILES: C=C(CO)C(=O)OCC(COC(=O)C(=C)CO)c1ccc(C(=O)Oc2ccc(CCCCC)cc2)cc1] |
| 1ϵ-10-128 | 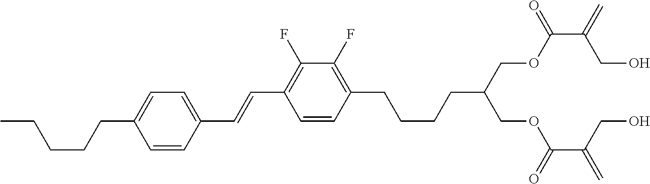 [SMILES: C=C(CO)C(=O)OCC(CCCCc1ccc(/C=C/c2ccc(CCCCC)cc2)c(F)c1F)COC(=O)C(=C)CO] |
| 1ϵ-10-129 | 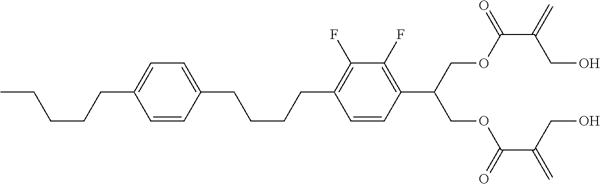 [SMILES: C=C(CO)C(=O)OCC(COC(=O)C(=C)CO)c1ccc(CCCCc2ccc(CCCCC)cc2)c(F)c1F] |
| 1ϵ-10-130 | 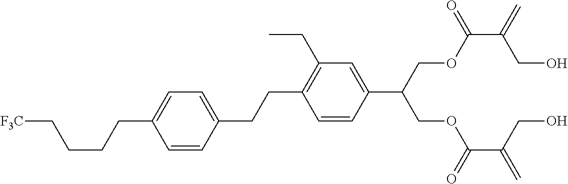 [SMILES: C=C(CO)C(=O)OCC(COC(=O)C(=C)CO)c1ccc(CCc2ccc(CCCCC(F)(F)F)cc2)c(CC)c1] |
| 1ϵ-10-131 | 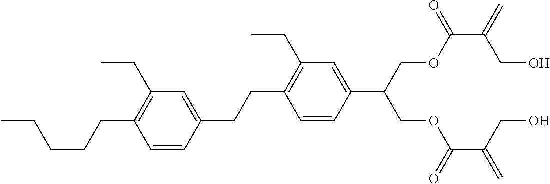 [SMILES: C=C(CO)C(=O)OCC(COC(=O)C(=C)CO)c1ccc(CCc2ccc(CCCCC)c(CC)c2)c(CC)c1] |
| 1ϵ-10-132 | 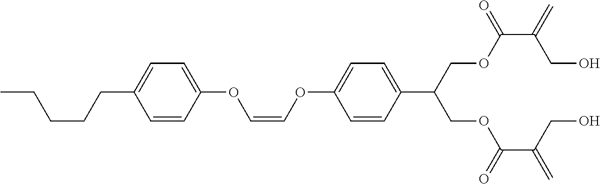 [SMILES: C=C(CO)C(=O)OCC(COC(=O)C(=C)CO)c1ccc(O/C=C\Oc2ccc(CCCCC)cc2)cc1] |
| 1ϵ-10-133 | 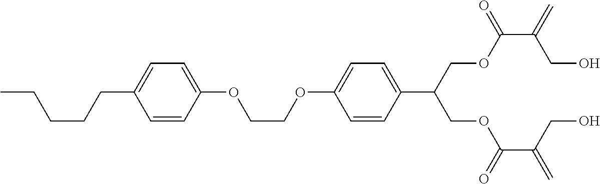 [SMILES: C=C(CO)C(=O)OCC(COC(=O)C(=C)CO)c1ccc(OCCOc2ccc(CCCCC)cc2)cc1] |
| 1ϵ-10-134 | 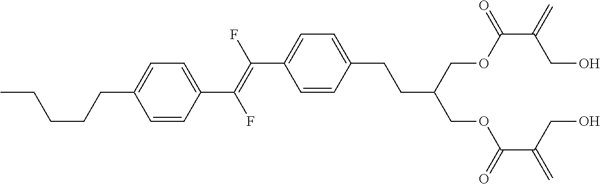 [SMILES: C=C(CO)C(=O)OCC(CCc1ccc(/C(F)=C(\F)c2ccc(CCCCC)cc2)cc1)COC(=O)C(=C)CO] |
| 1ϵ-10-135 | 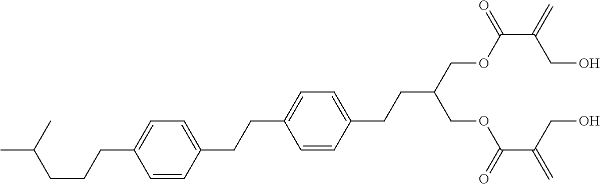 [SMILES: C=C(CO)C(=O)OCC(CCc1ccc(CCc2ccc(CCCC(C)C)cc2)cc1)COC(=O)C(=C)CO] |
| 1ϵ-10-136 | 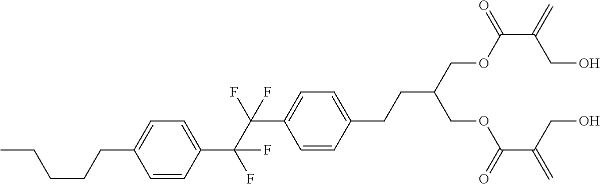 [SMILES: C=C(CO)C(=O)OCC(CCc1ccc(C(F)(F)C(F)(F)c2ccc(CCCCC)cc2)cc1)COC(=O)C(=C)CO] |
| 1ϵ-10-137 | 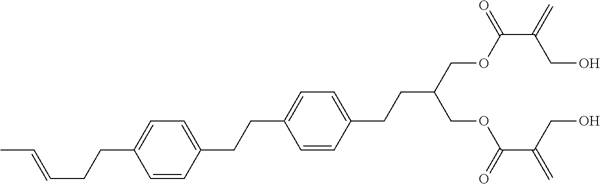 [SMILES: C=C(CO)C(=O)OCC(CCc1ccc(CCc2ccc(CC/C=C/C)cc2)cc1)COC(=O)C(=C)CO] |
| 1ϵ-10-138 | 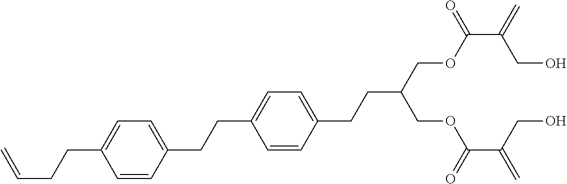 [SMILES: C=CCCc1ccc(CCc2ccc(CCC(COC(=O)C(=C)CO)COC(=O)C(=C)CO)cc2)cc1] |
| 1ϵ-10-139 | 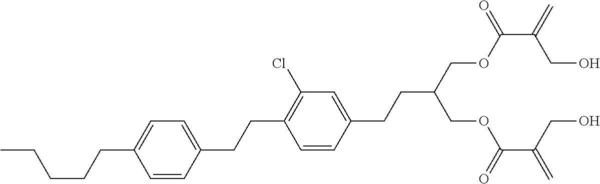 [SMILES: C=C(CO)C(=O)OCC(CCc1ccc(CCc2ccc(CCCCC)cc2)c(Cl)c1)COC(=O)C(=C)CO] |
| 1ϵ-10-140 | 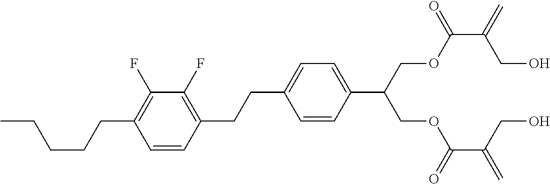 [SMILES: C=C(CO)C(=O)OCC(COC(=O)C(=C)CO)c1ccc(CCc2ccc(CCCCC)c(F)c2F)cc1] |
| 1ϵ-10-141 | 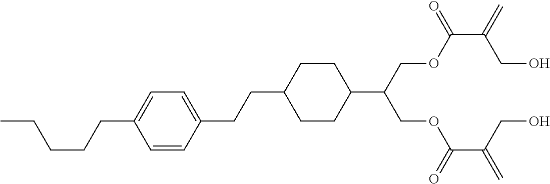 [SMILES: C=C(CO)C(=O)OCC(COC(=O)C(=C)CO)C1CCC(CCc2ccc(CCCCC)cc2)CC1] |
| 1ϵ-10-142 | 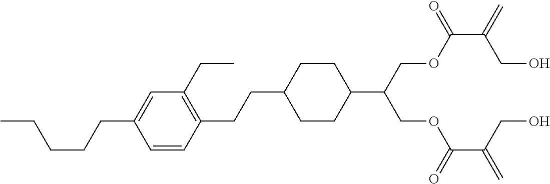 [SMILES: C=C(CO)C(=O)OCC(COC(=O)C(=C)CO)C1CCC(CCc2ccc(CCCCC)cc2CC)CC1] |
| 1ϵ-10-143 | 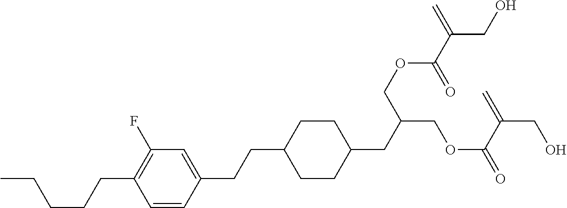 [SMILES: C=C(CO)C(=O)OCC(COC(=O)C(=C)CO)CC1CCC(CCc2ccc(CCCCC)c(F)c2)CC1] |
| 1ϵ-10-144 | 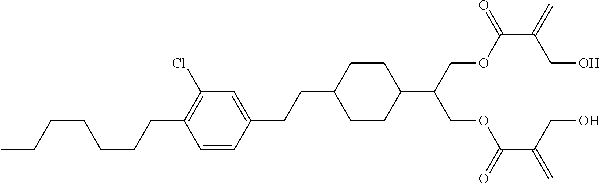 [SMILES: C=C(CO)C(=O)OCC(COC(=O)C(=C)CO)C1CCC(CCc2ccc(CCCCCCC)c(Cl)c2)CC1] |
| 1ϵ-10-145 | 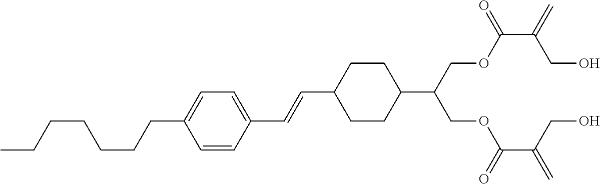 [SMILES: C=C(CO)C(=O)OCC(COC(=O)C(=C)CO)C1CCC(/C=C/c2ccc(CCCCCCC)cc2)CC1] |
| 1ϵ-10-146 | 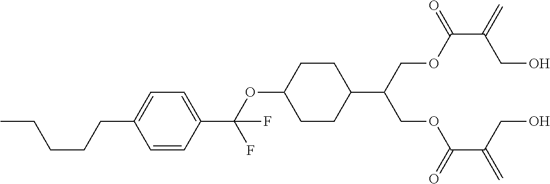 [SMILES: C=C(CO)C(=O)OCC(COC(=O)C(=C)CO)C1CCC(OC(F)(F)c2ccc(CCCCC)cc2)CC1] |
| 1ϵ-10-147 | 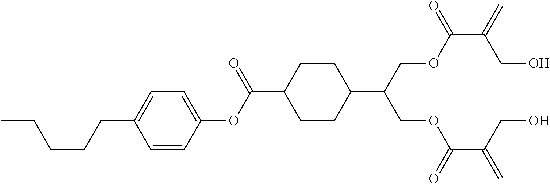 [SMILES: C=C(CO)C(=O)OCC(COC(=O)C(=C)CO)C1CCC(C(=O)Oc2ccc(CCCCC)cc2)CC1] |
| 1ϵ-10-148 | 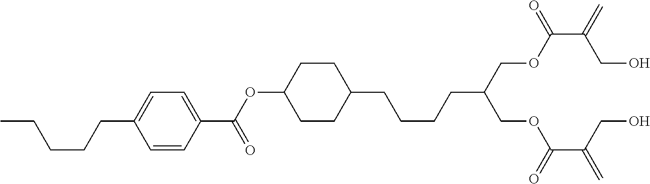 [SMILES: C=C(CO)C(=O)OCC(CCCCC1CCC(OC(=O)c2ccc(CCCCC)cc2)CC1)COC(=O)C(=C)CO] |
| 1ϵ-10-149 | 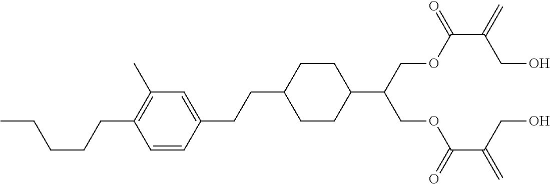 [SMILES: C=C(CO)C(=O)OCC(COC(=O)C(=C)CO)C1CCC(CCc2ccc(CCCCC)c(C)c2)CC1] |
| 1ϵ-10-150 | 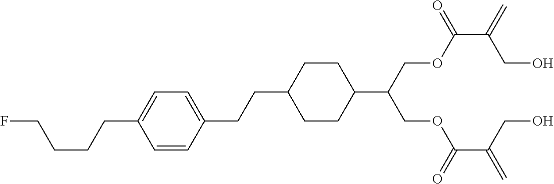 [SMILES: C=C(CO)C(=O)OCC(COC(=O)C(=C)CO)C1CCC(CCc2ccc(CCCCF)cc2)CC1] |
| 1ϵ-10-151 | 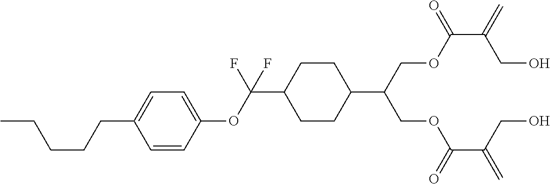 [SMILES: C=C(CO)C(=O)OCC(COC(=O)C(=C)CO)C1CCC(C(F)(F)Oc2ccc(CCCCC)cc2)CC1] |
| 1ϵ-10-152 | 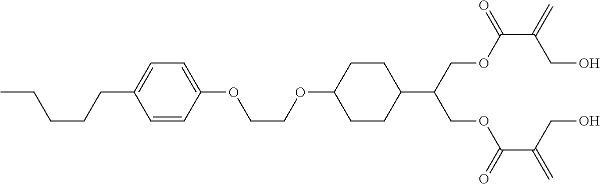 [SMILES: C=C(CO)C(=O)OCC(COC(=O)C(=C)CO)C1CCC(OCCOc2ccc(CCCCC)cc2)CC1] |
| 1ϵ-10-153 | 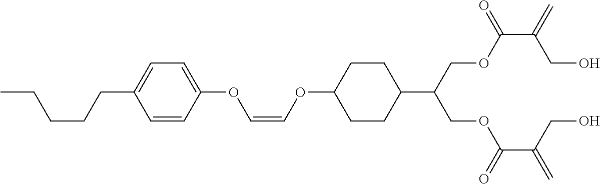 [SMILES: C=C(CO)C(=O)OCC(COC(=O)C(=C)CO)C1CCC(O/C=C\Oc2ccc(CCCCC)cc2)CC1] |
| 1ϵ-10-154 | 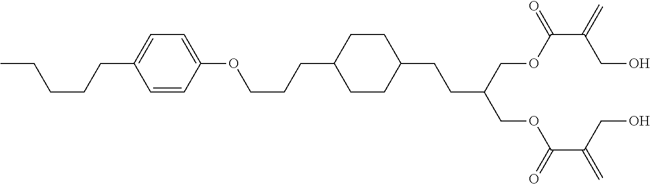 [SMILES: C=C(CO)C(=O)OCC(CCC1CCC(CCCOc2ccc(CCCCC)cc2)CC1)COC(=O)C(=C)CO] |
| 1ϵ-10-155 | 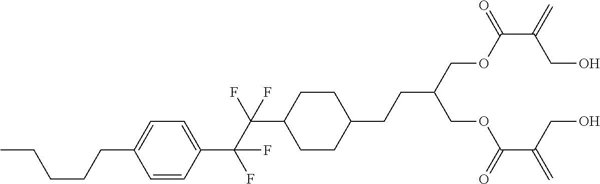 [SMILES: C=C(CO)C(=O)OCC(CCC1CCC(C(F)(F)C(F)(F)c2ccc(CCCCC)cc2)CC1)COC(=O)C(=C)CO] |
| 1ϵ-10-156 | 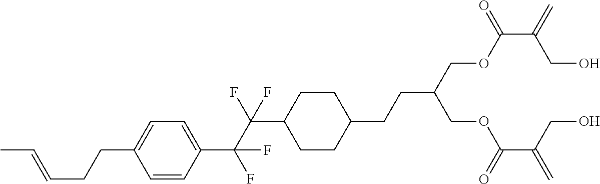 [SMILES: C=C(CO)C(=O)OCC(CCC1CCC(C(F)(F)C(F)(F)c2ccc(CC/C=C/C)cc2)CC1)COC(=O)C(=C)CO] |
| 1ϵ-10-157 | 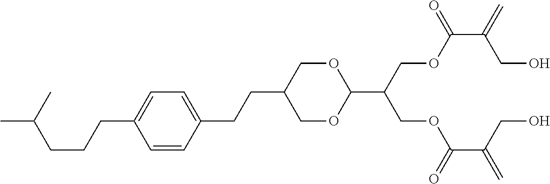 [SMILES: C=C(CO)C(=O)OCC(COC(=O)C(=C)CO)C1OCC(CCc2ccc(CCCC(C)C)cc2)CO1] |
| 1ϵ-10-158 | 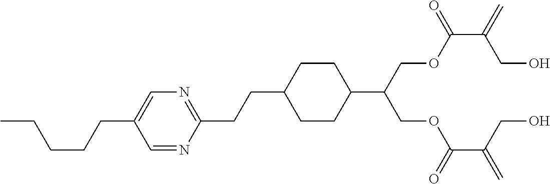 [SMILES: C=C(CO)C(=O)OCC(COC(=O)C(=C)CO)C1CCC(CCc2ncc(CCCCC)cn2)CC1] |
| 1ϵ-10-159 | 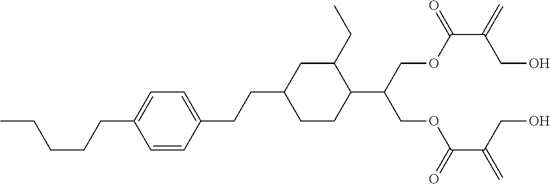 [SMILES: C=C(CO)C(=O)OCC(COC(=O)C(=C)CO)C1CCC(CCc2ccc(CCCCC)cc2)CC1CC] |
| 1ϵ-10-160 | 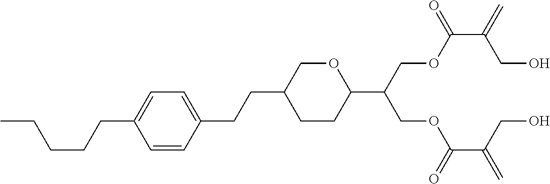 [SMILES: C=C(CO)C(=O)OCC(COC(=O)C(=C)CO)C1CCC(CCc2ccc(CCCCC)cc2)CO1] |
| 1ϵ-10-161 | 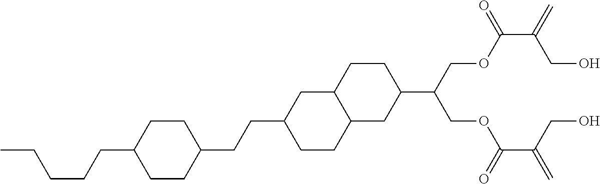 [SMILES: C=C(CO)C(=O)OCC(COC(=O)C(=C)CO)C1CCC2CC(CCC3CCC(CCCCC)CC3)CCC2C1] |
| 1ϵ-10-162 | 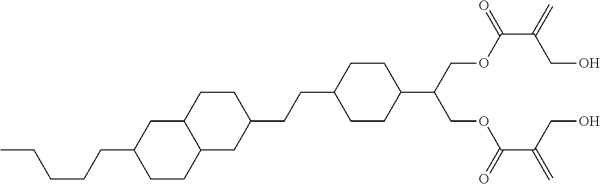 [SMILES: C=C(CO)C(=O)OCC(COC(=O)C(=C)CO)C1CCC(CCC2CCC3CC(CCCCC)CCC3C2)CC1] |
| 1ϵ-10-163 | 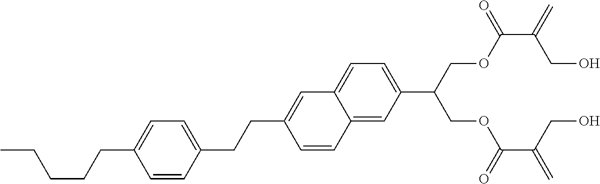 [SMILES: C=C(CO)C(=O)OCC(COC(=O)C(=C)CO)c1ccc2cc(CCc3ccc(CCCCC)cc3)ccc2c1] |
| 1ϵ-10-164 | 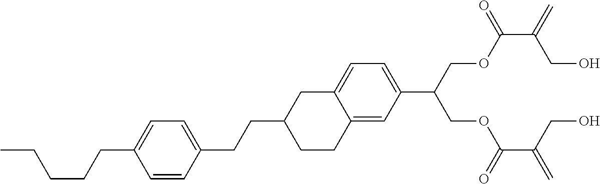 [SMILES: C=C(CO)C(=O)OCC(COC(=O)C(=C)CO)c1ccc2c(c1)CCC(CCc1ccc(CCCCC)cc1)C2] |
| 1ϵ-10-165 | 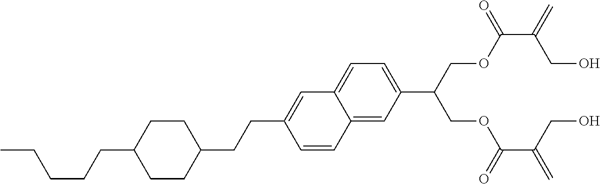 [SMILES: C=C(CO)C(=O)OCC(COC(=O)C(=C)CO)c1ccc2cc(CCC3CCC(CCCCC)CC3)ccc2c1] |
| 1ϵ-10-166 | 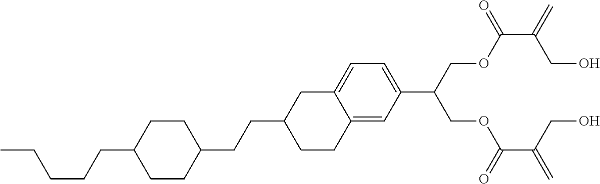 [SMILES: C=C(CO)C(=O)OCC(COC(=O)C(=C)CO)c1ccc2c(c1)CCC(CCC1CCC(CCCCC)CC1)C2] |
| 1ϵ-10-167 | 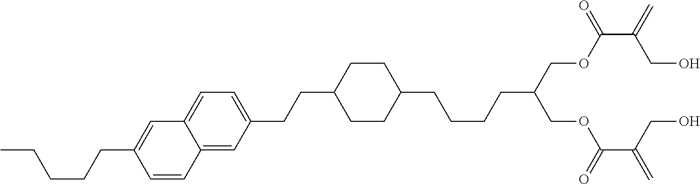 [SMILES: C=C(CO)C(=O)OCC(CCCCC1CCC(CCc2ccc3cc(CCCCC)ccc3c2)CC1)COC(=O)C(=C)CO] |
| 1ϵ-10-168 | 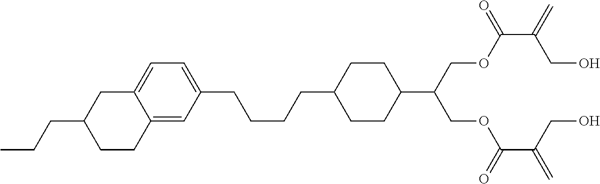 [SMILES: C=C(CO)C(=O)OCC(COC(=O)C(=C)CO)C1CCC(CCCCc2ccc3c(c2)CCC(CCC)C3)CC1] |
| 1ϵ-10-169 | 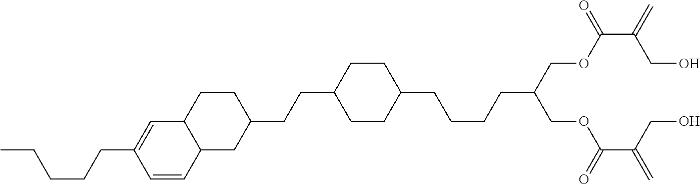 [SMILES: C=C(CO)C(=O)OCC(CCCCC1CCC(CCC2CCC3C=C(CCCCC)C=CC3C2)CC1)COC(=O)C(=C)CO] |
| 1ϵ-10-170 | 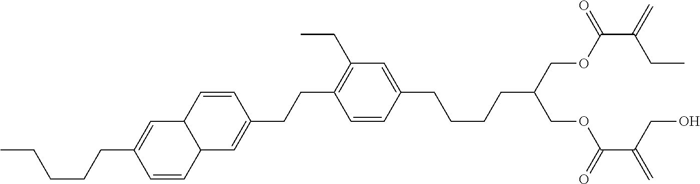 [SMILES: C=C(CC)C(=O)OCC(CCCCc1ccc(CCC2=CC3C=CC(CCCCC)=CC3C=C2)c(CC)c1)COC(=O)C(=C)CO] |
| 1ϵ-10-171 | 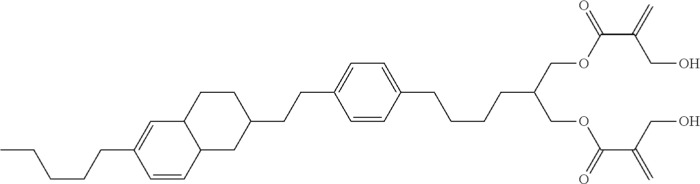 [SMILES: C=C(CO)C(=O)OCC(CCCCc1ccc(CCC2CCC3C=C(CCCCC)C=CC3C2)cc1)COC(=O)C(=C)CO] |
| 1ϵ-10-172 | 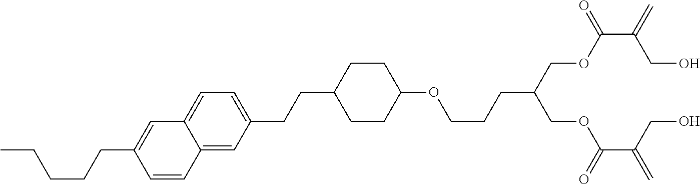 [SMILES: C=C(CO)C(=O)OCC(CCCOC1CCC(CCc2ccc3cc(CCCCC)ccc3c2)CC1)COC(=O)C(=C)CO] |
| 1ϵ-10-173 | 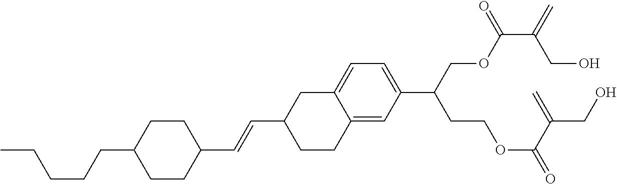 [SMILES: C=C(CO)C(=O)OCCC(COC(=O)C(=C)CO)c1ccc2c(c1)CCC(/C=C/C1CCC(CCCCC)CC1)C2] |
| 1ϵ-10-174 | 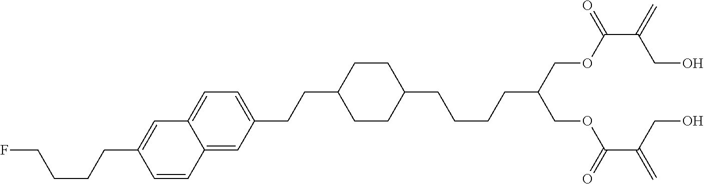 [SMILES: C=C(CO)C(=O)OCC(CCCCC1CCC(CCc2ccc3cc(CCCCF)ccc3c2)CC1)COC(=O)C(=C)CO] |
| 1ϵ-10-175 | 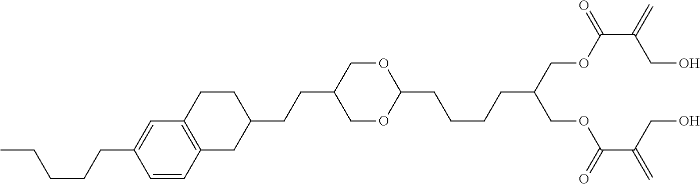 [SMILES: C=C(CO)C(=O)OCC(CCCCC1OCC(CCC2CCc3cc(CCCCC)ccc3C2)CO1)COC(=O)C(=C)CO] |
| 1ϵ-10-176 | 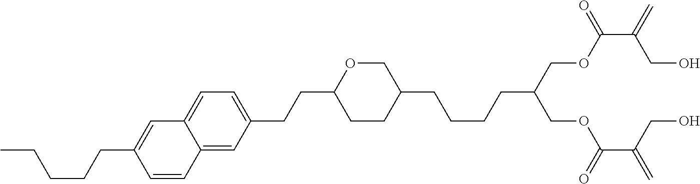 [SMILES: C=C(CO)C(=O)OCC(CCCCC1CCC(CCc2ccc3cc(CCCCC)ccc3c2)OC1)COC(=O)C(=C)CO] |
| 1ϵ-10-177 | 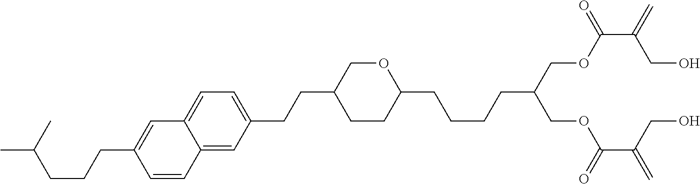 [SMILES: C=C(CO)C(=O)OCC(CCCCC1CCC(CCc2ccc3cc(CCCC(C)C)ccc3c2)CO1)COC(=O)C(=C)CO] |
| 1ϵ-10-178 | 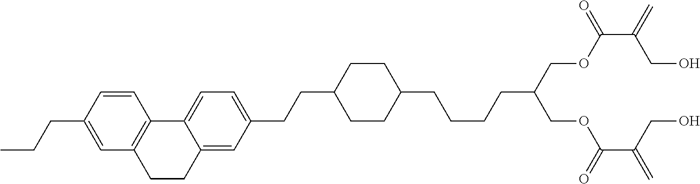 [SMILES: C=C(CO)C(=O)OCC(CCCCC1CCC(CCc2ccc3c(c2)CCc2cc(CCC)ccc2-3)CC1)COC(=O)C(=C)CO] |
| 1ϵ-10-179 | 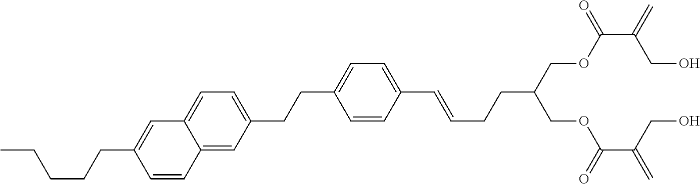 [SMILES: C=C(CO)C(=O)OCC(CC/C=C/c1ccc(CCc2ccc3cc(CCCCC)ccc3c2)cc1)COC(=O)C(=C)CO] |
| 1ϵ-10-180 | 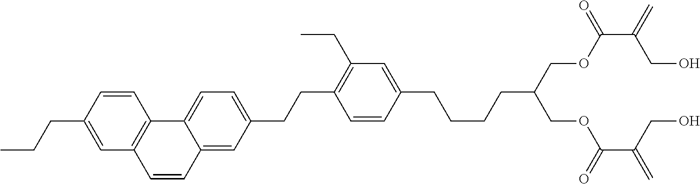 [SMILES: C=C(CO)C(=O)OCC(CCCCc1ccc(CCc2ccc3c(ccc4cc(CCC)ccc43)c2)c(CC)c1)COC(=O)C(=C)CO] |
| 1ϵ-10-181 | 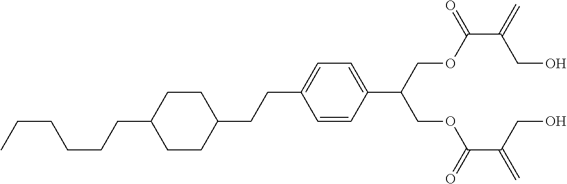 [SMILES: C=C(CO)C(=O)OCC(COC(=O)C(=C)CO)c1ccc(CCC2CCC(CCCCCC)CC2)cc1] |
| 1ϵ-10-182 | 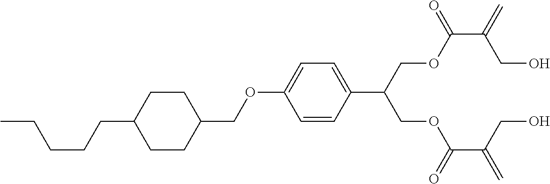 [SMILES: C=C(CO)C(=O)OCC(COC(=O)C(=C)CO)c1ccc(OCC2CCC(CCCCC)CC2)cc1] |
| 1ϵ-10-183 | 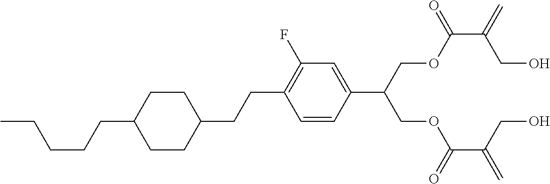 [SMILES: C=C(CO)C(=O)OCC(COC(=O)C(=C)CO)c1ccc(CCC2CCC(CCCCC)CC2)c(F)c1] |
| 1ϵ-10-184 | 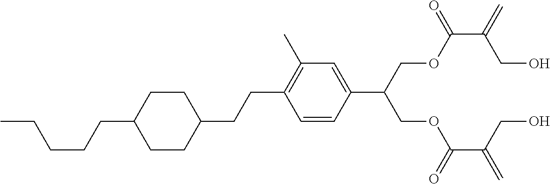 [SMILES: C=C(CO)C(=O)OCC(COC(=O)C(=C)CO)c1ccc(CCC2CCC(CCCCC)CC2)c(C)c1] |
| 1ϵ-10-185 | 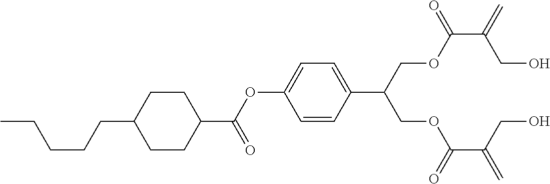 [SMILES: C=C(CO)C(=O)OCC(COC(=O)C(=C)CO)c1ccc(OC(=O)C2CCC(CCCCC)CC2)cc1] |
| 1ϵ-10-186 | 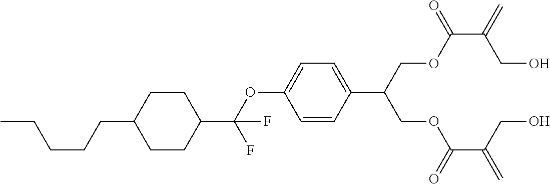 [SMILES: C=C(CO)C(=O)OCC(COC(=O)C(=C)CO)c1ccc(OC(F)(F)C2CCC(CCCCC)CC2)cc1] |
| 1ϵ-10-187 | 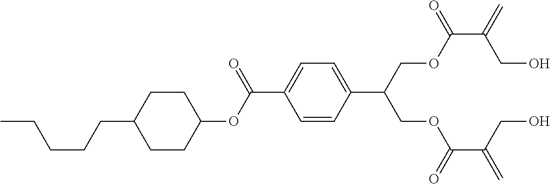 [SMILES: C=C(CO)C(=O)OCC(COC(=O)C(=C)CO)c1ccc(C(=O)OC2CCC(CCCCC)CC2)cc1] |
| 1ϵ-10-188 | 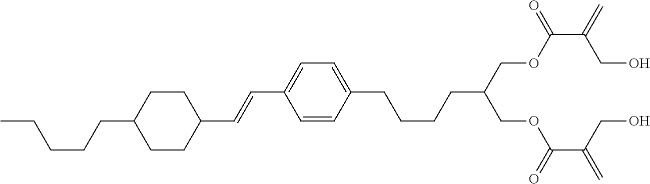 [SMILES: C=C(CO)C(=O)OCC(CCCCc1ccc(/C=C/C2CCC(CCCCC)CC2)cc1)COC(=O)C(=C)CO] |
| 1ϵ-10-189 | 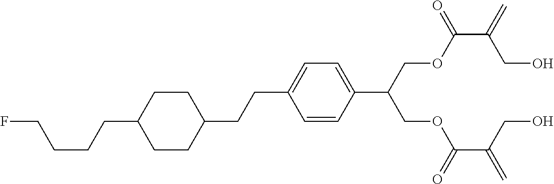 [SMILES: C=C(CO)C(=O)OCC(COC(=O)C(=C)CO)c1ccc(CCC2CCC(CCCCF)CC2)cc1] |
| 1ϵ-10-190 | 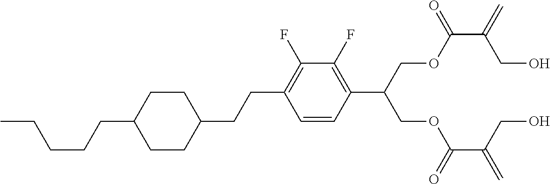 [SMILES: C=C(CO)C(=O)OCC(COC(=O)C(=C)CO)c1ccc(CCC2CCC(CCCCC)CC2)c(F)c1F] |
| 1ϵ-10-191 | 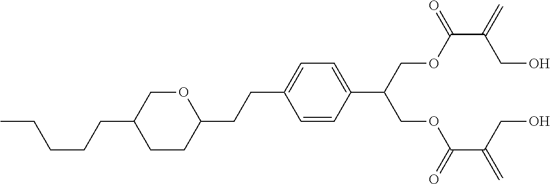 [SMILES: C=C(CO)C(=O)OCC(COC(=O)C(=C)CO)c1ccc(CCC2CCC(CCCCC)CO2)cc1] |
| 1ϵ-10-192 | 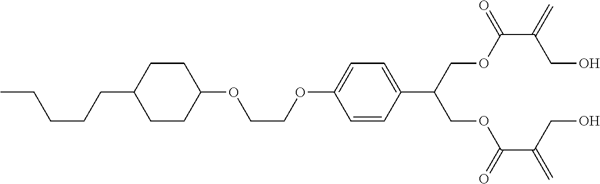 [SMILES: C=C(CO)C(=O)OCC(COC(=O)C(=C)CO)c1ccc(OCCOC2CCC(CCCCC)CC2)cc1] |
| 1ϵ-10-193 | 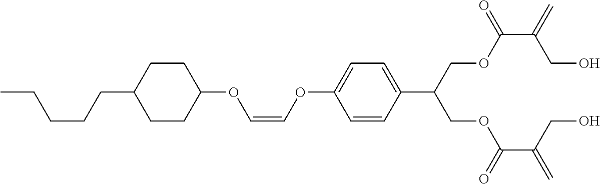 [SMILES: C=C(CO)C(=O)OCC(COC(=O)C(=C)CO)c1ccc(O/C=C\OC2CCC(CCCCC)CC2)cc1] |
| 1ϵ-10-194 | 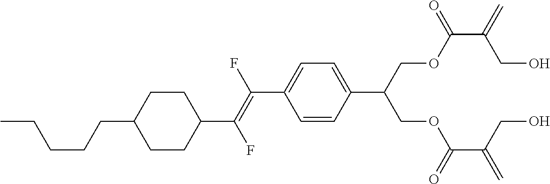 [SMILES: C=C(CO)C(=O)OCC(COC(=O)C(=C)CO)c1ccc(/C(F)=C(\F)C2CCC(CCCCC)CC2)cc1] |
| 1ϵ-10-195 | 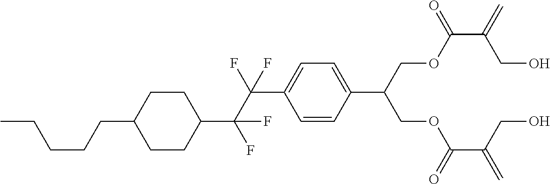 [SMILES: C=C(CO)C(=O)OCC(COC(=O)C(=C)CO)c1ccc(C(F)(F)C(F)(F)C2CCC(CCCCC)CC2)cc1] |
| 1ϵ-10-196 | 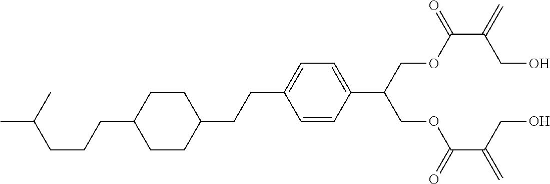 [SMILES: C=C(CO)C(=O)OCC(COC(=O)C(=C)CO)c1ccc(CCC2CCC(CCCC(C)C)CC2)cc1] |
| 1ϵ-10-197 | 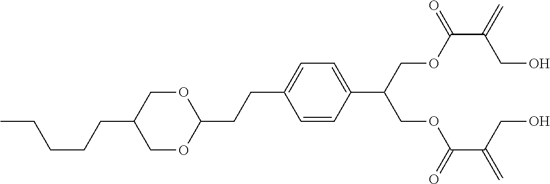 [SMILES: C=C(CO)C(=O)OCC(COC(=O)C(=C)CO)c1ccc(CCC2OCC(CCCCC)CO2)cc1] |
| 1ϵ-10-198 | 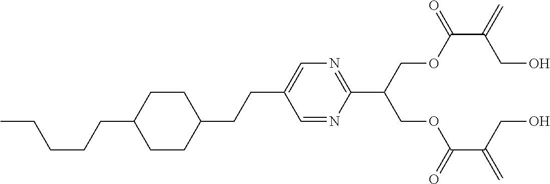 [SMILES: C=C(CO)C(=O)OCC(COC(=O)C(=C)CO)c1ncc(CCC2CCC(CCCCC)CC2)cn1] |
| 1ϵ-10-199 | 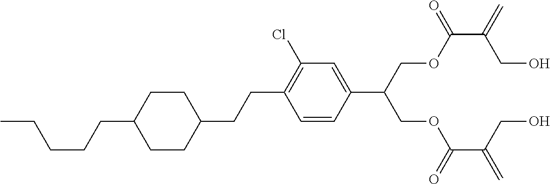 [SMILES: C=C(CO)C(=O)OCC(COC(=O)C(=C)CO)c1ccc(CCC2CCC(CCCCC)CC2)c(Cl)c1] |
| 1ϵ-10-200 | 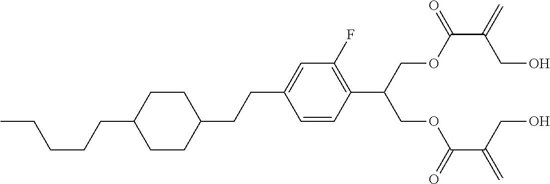 [SMILES: C=C(CO)C(=O)OCC(COC(=O)C(=C)CO)c1ccc(CCC2CCC(CCCCC)CC2)cc1F] |
| 1ϵ-11-1 | 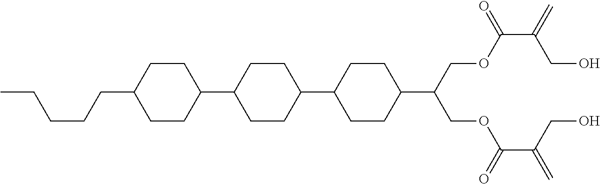 [SMILES: C=C(CO)C(=O)OCC(COC(=O)C(=C)CO)C1CCC(C2CCC(C3CCC(CCCCC)CC3)CC2)CC1] |
| 1ϵ-11-2 | 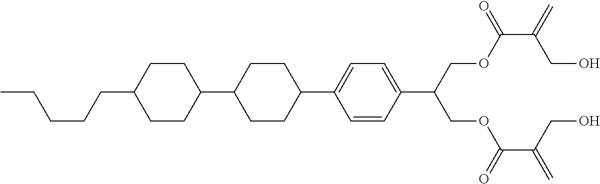 [SMILES: C=C(CO)C(=O)OCC(COC(=O)C(=C)CO)c1ccc(C2CCC(C3CCC(CCCCC)CC3)CC2)cc1] |
| 1ϵ-11-3 | 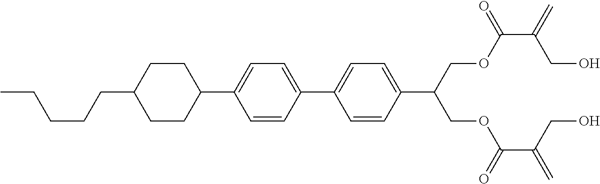 [SMILES: C=C(CO)C(=O)OCC(COC(=O)C(=C)CO)c1ccc(-c2ccc(C3CCC(CCCCC)CC3)cc2)cc1] |
| 1ϵ-11-4 | 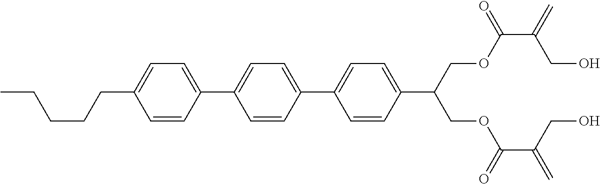 [SMILES: C=C(CO)C(=O)OCC(COC(=O)C(=C)CO)c1ccc(-c2ccc(-c3ccc(CCCCC)cc3)cc2)cc1] |
| 1ϵ-11-5 | 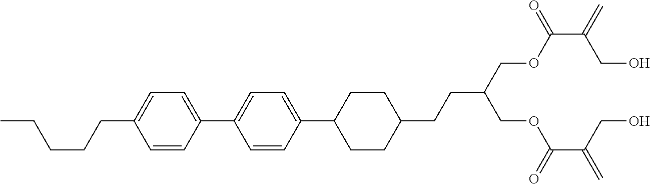 [SMILES: C=C(CO)C(=O)OCC(CCC1CCC(c2ccc(-c3ccc(CCCCC)cc3)cc2)CC1)COC(=O)C(=C)CO] |
| 1ϵ-11-6 | 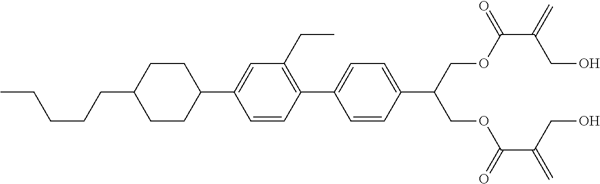 [SMILES: C=C(CO)C(=O)OCC(COC(=O)C(=C)CO)c1ccc(-c2ccc(C3CCC(CCCCC)CC3)cc2CC)cc1] |
| 1ϵ-11-7 | 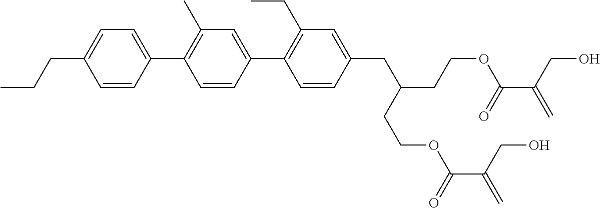 [SMILES: C=C(CO)C(=O)OCCC(CCOC(=O)C(=C)CO)Cc1ccc(-c2ccc(-c3ccc(CCC)cc3)c(C)c2)c(CC)c1] |
| 1ϵ-11-8 | 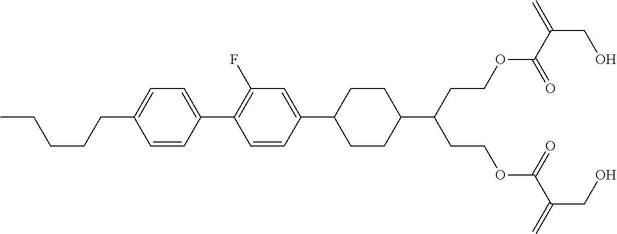 [SMILES: C=C(CO)C(=O)OCCC(CCOC(=O)C(=C)CO)C1CCC(c2ccc(-c3ccc(CCCCC)cc3)c(F)c2)CC1] |
| 1ϵ-11-9 | 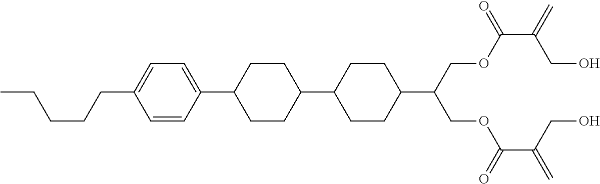 [SMILES: C=C(CO)C(=O)OCC(COC(=O)C(=C)CO)C1CCC(C2CCC(c3ccc(CCCCC)cc3)CC2)CC1] |
| 1ϵ-11-10 | 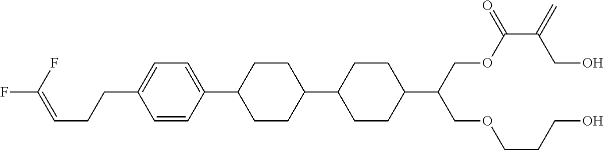 [SMILES: C=C(CO)C(=O)OCC(COCCCO)C1CCC(C2CCC(c3ccc(CCC=C(F)F)cc3)CC2)CC1] |
| 1ϵ-11-11 | 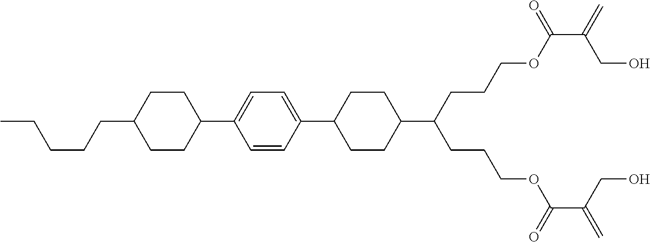 [SMILES: C=C(CO)C(=O)OCCCC(CCCOC(=O)C(=C)CO)C1CCC(c2ccc(C3CCC(CCCCC)CC3)cc2)CC1] |
| 1ϵ-11-12 | 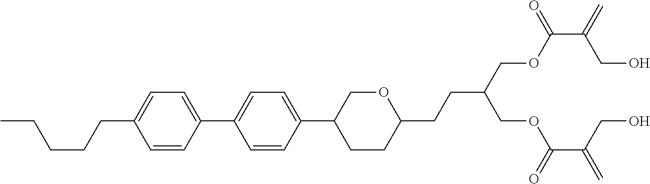 [SMILES: C=C(CO)C(=O)OCC(CCC1CCC(c2ccc(-c3ccc(CCCCC)cc3)cc2)CO1)COC(=O)C(=C)CO] |
| 1ϵ-11-13 | 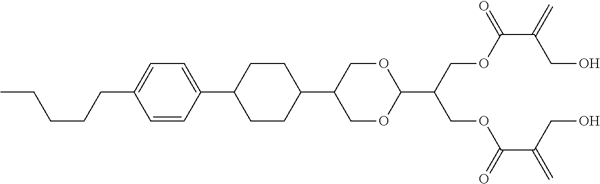 [SMILES: C=C(CO)C(=O)OCC(COC(=O)C(=C)CO)C1OCC(C2CCC(c3ccc(CCCCC)cc3)CC2)CO1] |
| 1ϵ-11-14 | 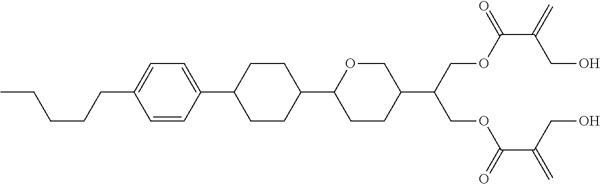 [SMILES: C=C(CO)C(=O)OCC(COC(=O)C(=C)CO)C1CCC(C2CCC(c3ccc(CCCCC)cc3)CC2)OC1] |
| 1ϵ-11-15 | 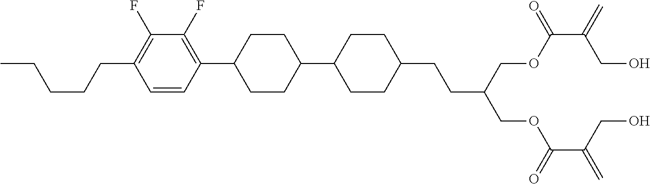 [SMILES: C=C(CO)C(=O)OCC(CCC1CCC(C2CCC(c3ccc(CCCCC)c(F)c3F)CC2)CC1)COC(=O)C(=C)CO] |
| 1ϵ-11-16 | 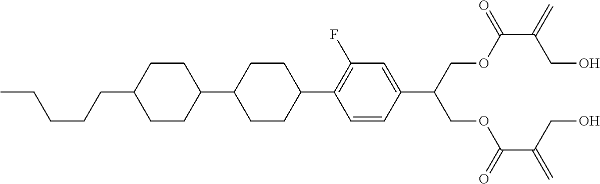 [SMILES: C=C(CO)C(=O)OCC(COC(=O)C(=C)CO)c1ccc(C2CCC(C3CCC(CCCCC)CC3)CC2)c(F)c1] |
| 1ϵ-11-17 | 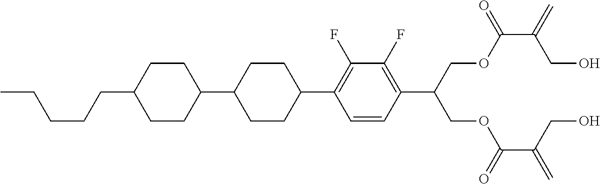 [SMILES: C=C(CO)C(=O)OCC(COC(=O)C(=C)CO)c1ccc(C2CCC(C3CCC(CCCCC)CC3)CC2)c(F)c1F] |
| 1ϵ-11-18 | 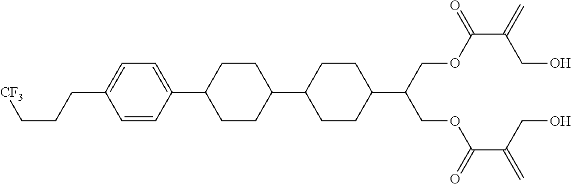 [SMILES: C=C(CO)C(=O)OCC(COC(=O)C(=C)CO)C1CCC(C2CCC(c3ccc(CCCC(F)(F)F)cc3)CC2)CC1] |
| 1ϵ-11-19 | 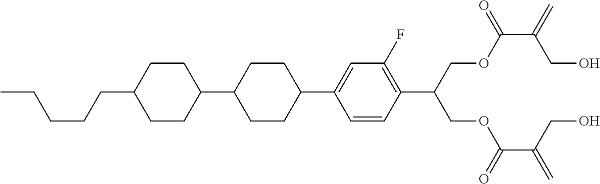 [SMILES: C=C(CO)C(=O)OCC(COC(=O)C(=C)CO)c1ccc(C2CCC(C3CCC(CCCCC)CC3)CC2)cc1F] |
| 1ϵ-11-20 | 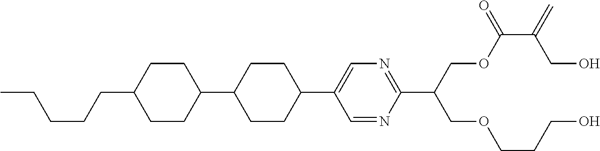 [SMILES: C=C(CO)C(=O)OCC(COCCCO)c1ncc(C2CCC(C3CCC(CCCCC)CC3)CC2)cn1] |
| 1ϵ-11-21 | 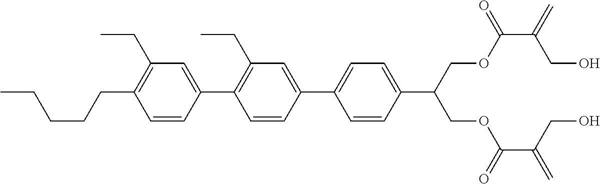 [SMILES: C=C(CO)C(=O)OCC(COC(=O)C(=C)CO)c1ccc(-c2ccc(-c3ccc(CCCCC)c(CC)c3)c(CC)c2)cc1] |
| 1ϵ-11-22 | 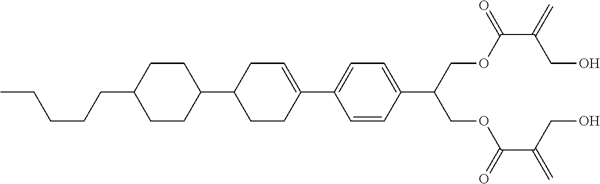 [SMILES: C=C(CO)C(=O)OCC(COC(=O)C(=C)CO)c1ccc(C2=CCC(C3CCC(CCCCC)CC3)CC2)cc1] |
| 1ϵ-11-23 | 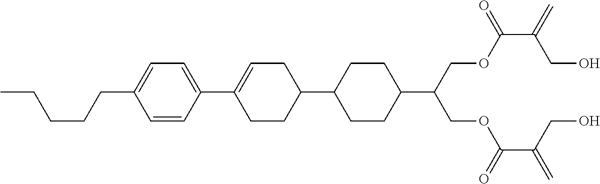 [SMILES: C=C(CO)C(=O)OCC(COC(=O)C(=C)CO)C1CCC(C2CC=C(c3ccc(CCCCC)cc3)CC2)CC1] |
| 1ϵ-11-24 | 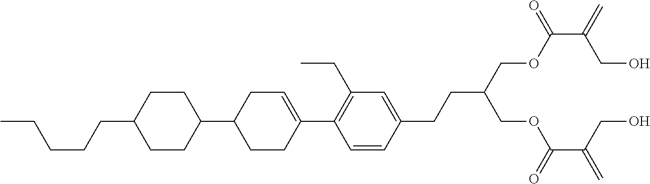 [SMILES: C=C(CO)C(=O)OCC(CCc1ccc(C2=CCC(C3CCC(CCCCC)CC3)CC2)c(CC)c1)COC(=O)C(=C)CO] |
| 1ϵ-11-25 | 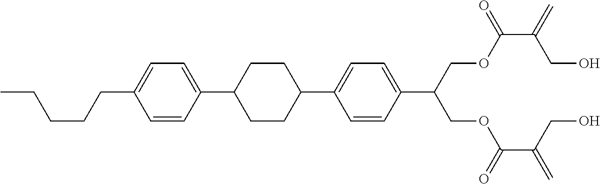 [SMILES: C=C(CO)C(=O)OCC(COC(=O)C(=C)CO)c1ccc(C2CCC(c3ccc(CCCCC)cc3)CC2)cc1] |
| 1ϵ-11-26 | 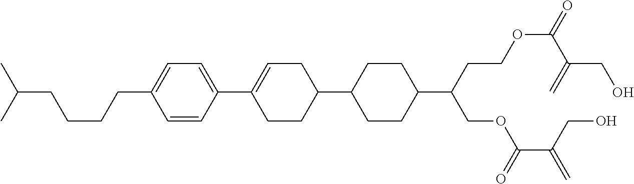 [SMILES: C=C(CO)C(=O)OCCC(COC(=O)C(=C)CO)C1CCC(C2CC=C(c3ccc(CCCCC(C)C)cc3)CC2)CC1] |
| 1ϵ-11-27 | 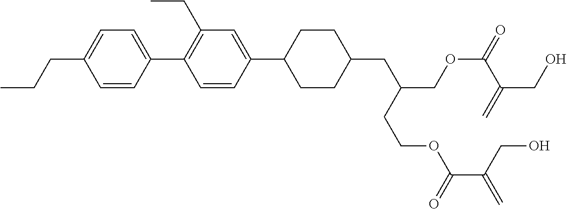 [SMILES: C=C(CO)C(=O)OCCC(COC(=O)C(=C)CO)CC1CCC(c2ccc(-c3ccc(CCC)cc3)c(CC)c2)CC1] |
| 1ϵ-11-28 | 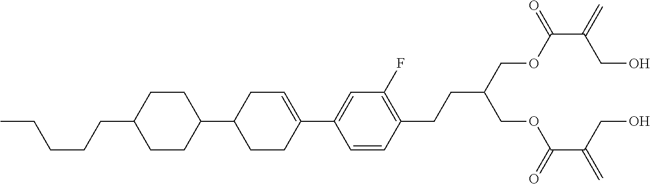 [SMILES: C=C(CO)C(=O)OCC(CCc1ccc(C2=CCC(C3CCC(CCCCC)CC3)CC2)cc1F)COC(=O)C(=C)CO] |
| 1ϵ-11-29 | 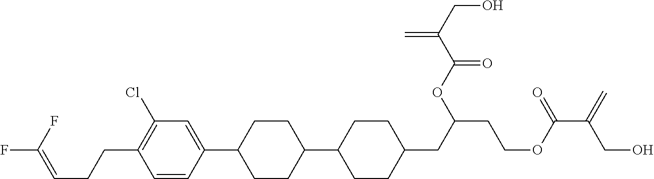 [SMILES: C=C(CO)C(=O)OCCC(CC1CCC(C2CCC(c3ccc(CCC=C(F)F)c(Cl)c3)CC2)CC1)OC(=O)C(=C)CO] |
| 1ϵ-11-30 | 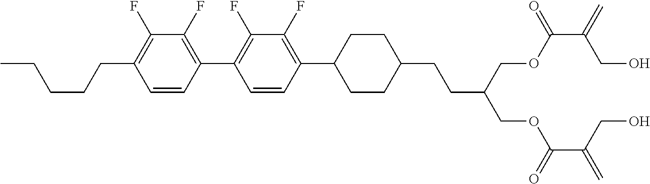 [SMILES: C=C(CO)C(=O)OCC(CCC1CCC(c2ccc(-c3ccc(CCCCC)c(F)c3F)c(F)c2F)CC1)COC(=O)C(=C)CO] |
| 1ϵ-11-31 | 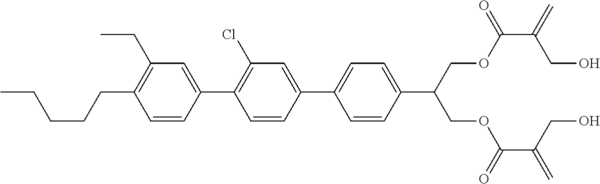 [SMILES: C=C(CO)C(=O)OCC(COC(=O)C(=C)CO)c1ccc(-c2ccc(-c3ccc(CCCCC)c(CC)c3)c(Cl)c2)cc1] |
| 1ϵ-11-32 | 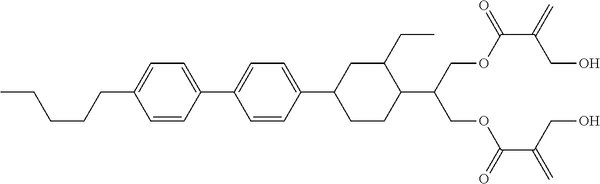 [SMILES: C=C(CO)C(=O)OCC(COC(=O)C(=C)CO)C1CCC(c2ccc(-c3ccc(CCCCC)cc3)cc2)CC1CC] |
| 1ϵ-11-33 | 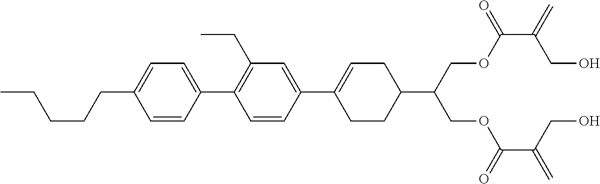 [SMILES: C=C(CO)C(=O)OCC(COC(=O)C(=C)CO)C1CC=C(c2ccc(-c3ccc(CCCCC)cc3)c(CC)c2)CC1] |
| 1ϵ-11-34 | 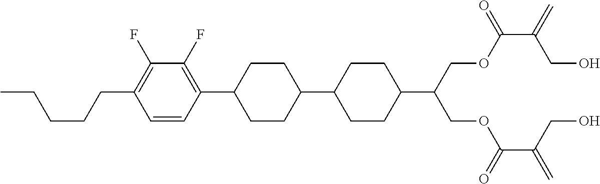 [SMILES: C=C(CO)C(=O)OCC(COC(=O)C(=C)CO)C1CCC(C2CCC(c3ccc(CCCCC)c(F)c3F)CC2)CC1] |
| 1ϵ-11-35 | 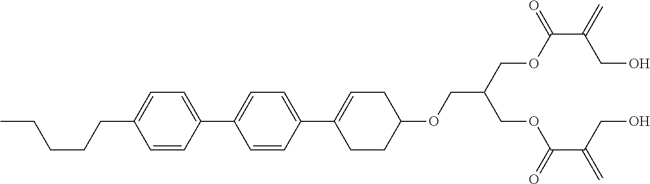 [SMILES: C=C(CO)C(=O)OCC(COC(=O)C(=C)CO)COC1CC=C(c2ccc(-c3ccc(CCCCC)cc3)cc2)CC1] |
| 1ϵ-11-36 | 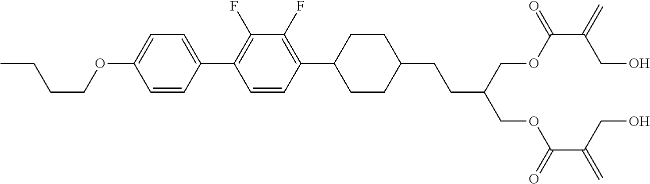 [SMILES: C=C(CO)C(=O)OCC(CCC1CCC(c2ccc(-c3ccc(OCCCC)cc3)c(F)c2F)CC1)COC(=O)C(=C)CO] |
| 1ϵ-11-37 | 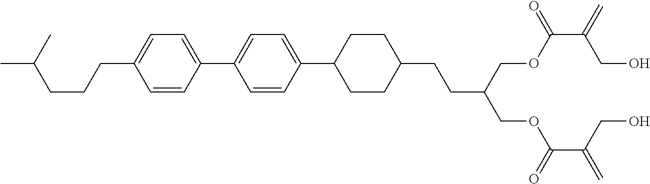 [SMILES: C=C(CO)C(=O)OCC(CCC1CCC(c2ccc(-c3ccc(CCCC(C)C)cc3)cc2)CC1)COC(=O)C(=C)CO] |
| 1ϵ-11-38 | 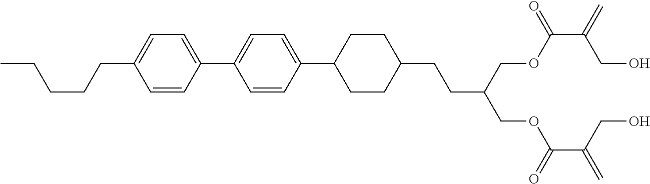 [SMILES: C=C(CO)C(=O)OCC(CCC1CCC(c2ccc(-c3ccc(CCCCC)cc3)cc2)CC1)COC(=O)C(=C)CO] |
| 1ϵ-11-39 | 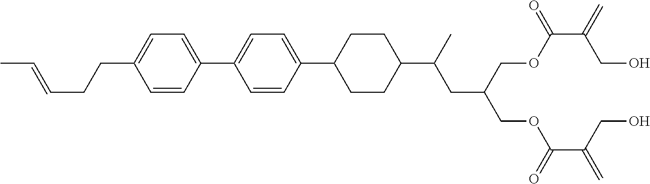 [SMILES: C=C(CO)C(=O)OCC(COC(=O)C(=C)CO)CC(C)C1CCC(c2ccc(-c3ccc(CC/C=C/C)cc3)cc2)CC1] |
| 1ϵ-11-40 | 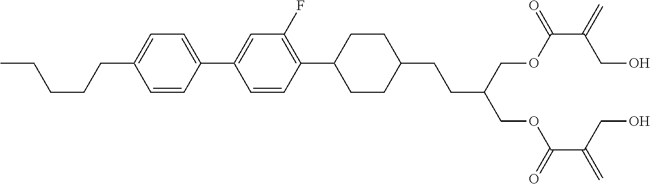 [SMILES: C=C(CO)C(=O)OCC(CCC1CCC(c2ccc(-c3ccc(CCCCC)cc3)cc2F)CC1)COC(=O)C(=C)CO] |
| 1ϵ-11-41 | 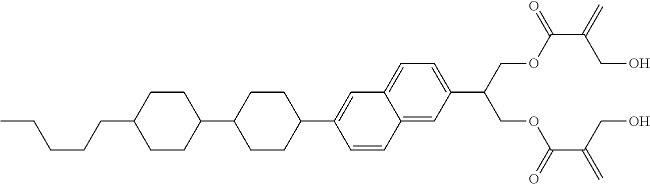 [SMILES: C=C(CO)C(=O)OCC(COC(=O)C(=C)CO)c1ccc2cc(C3CCC(C4CCC(CCCCC)CC4)CC3)ccc2c1] |
| 1ϵ-11-42 | 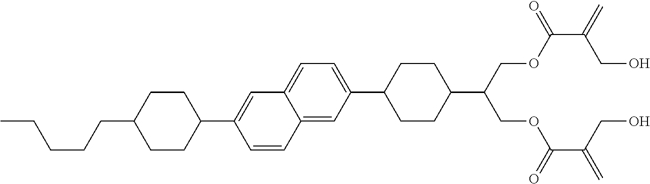 [SMILES: C=C(CO)C(=O)OCC(COC(=O)C(=C)CO)C1CCC(c2ccc3cc(C4CCC(CCCCC)CC4)ccc3c2)CC1] |
| 1ϵ-11-43 | 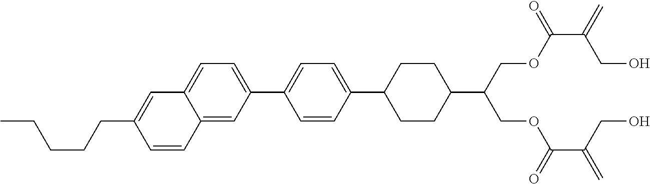 [SMILES: C=C(CO)C(=O)OCC(COC(=O)C(=C)CO)C1CCC(c2ccc(-c3ccc4cc(CCCCC)ccc4c3)cc2)CC1] |
| 1ϵ-11-44 | 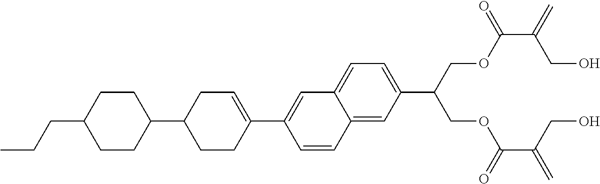 [SMILES: C=C(CO)C(=O)OCC(COC(=O)C(=C)CO)c1ccc2cc(C3=CCC(C4CCC(CCC)CC4)CC3)ccc2c1] |
| 1ϵ-11-45 | 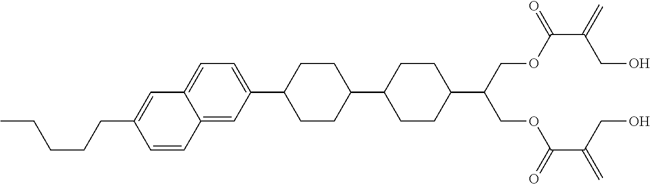 [SMILES: C=C(CO)C(=O)OCC(COC(=O)C(=C)CO)C1CCC(C2CCC(c3ccc4cc(CCCCC)ccc4c3)CC2)CC1] |
| 1ϵ-11-46 | 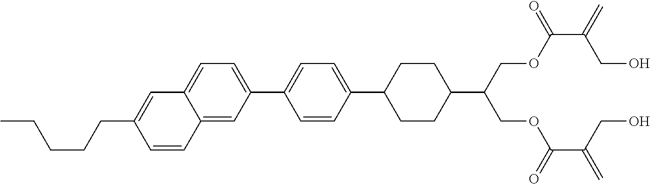 [SMILES: C=C(CO)C(=O)OCC(COC(=O)C(=C)CO)C1CCC(c2ccc(-c3ccc4cc(CCCCC)ccc4c3)cc2)CC1] |
| 1ϵ-11-47 | 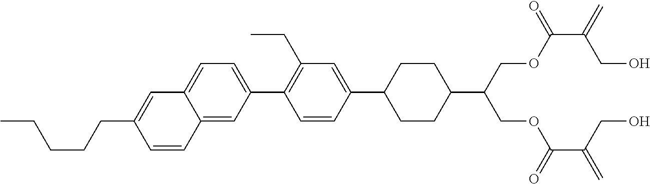 [SMILES: C=C(CO)C(=O)OCC(COC(=O)C(=C)CO)C1CCC(c2ccc(-c3ccc4cc(CCCCC)ccc4c3)c(CC)c2)CC1] |
| 1ϵ-11-48 | 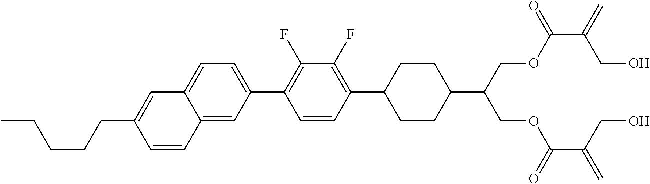 [SMILES: C=C(CO)C(=O)OCC(COC(=O)C(=C)CO)C1CCC(c2ccc(-c3ccc4cc(CCCCC)ccc4c3)c(F)c2F)CC1] |
| 1ϵ-11-49 | 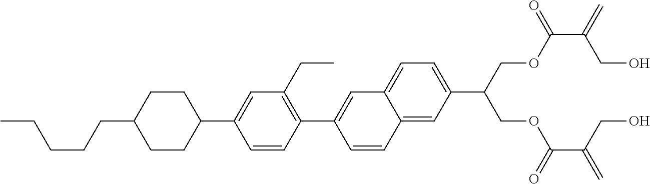 [SMILES: C=C(CO)C(=O)OCC(COC(=O)C(=C)CO)c1ccc2cc(-c3ccc(C4CCC(CCCCC)CC4)cc3CC)ccc2c1] |
| 1ϵ-11-50 | 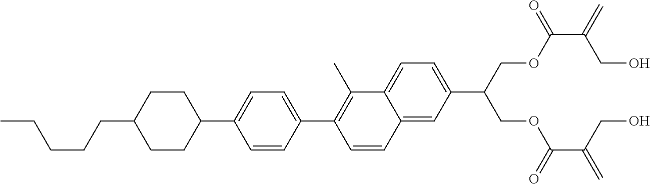 [SMILES: C=C(CO)C(=O)OCC(COC(=O)C(=C)CO)c1ccc2c(C)c(-c3ccc(C4CCC(CCCCC)CC4)cc3)ccc2c1] |
| 1ϵ-11-51 | 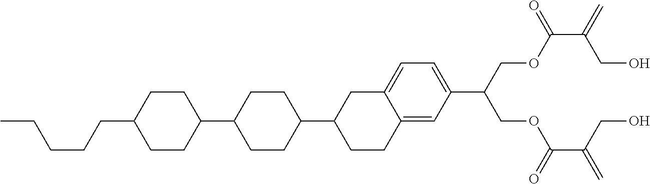 [SMILES: C=C(CO)C(=O)OCC(COC(=O)C(=C)CO)c1ccc2c(c1)CCC(C1CCC(C3CCC(CCCCC)CC3)CC1)C2] |
| 1ϵ-11-52 | 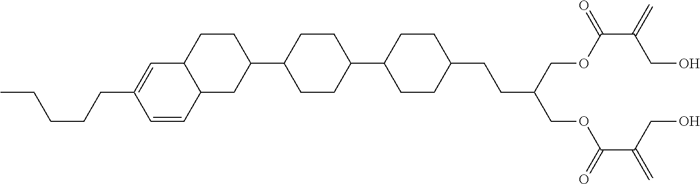 [SMILES: C=C(CO)C(=O)OCC(CCC1CCC(C2CCC(C3CCC4C=C(CCCCC)C=CC4C3)CC2)CC1)COC(=O)C(=C)CO] |
| 1ϵ-11-53 | 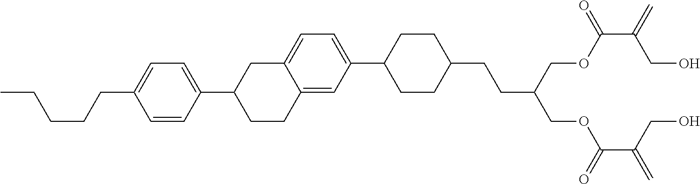 [SMILES: C=C(CO)C(=O)OCC(CCC1CCC(c2ccc3c(c2)CCC(c2ccc(CCCCC)cc2)C3)CC1)COC(=O)C(=C)CO] |
| 1ϵ-11-54 | 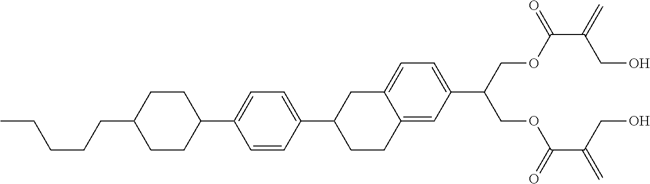 [SMILES: C=C(CO)C(=O)OCC(COC(=O)C(=C)CO)c1ccc2c(c1)CCC(c1ccc(C3CCC(CCCCC)CC3)cc1)C2] |
| 1ϵ-11-55 | 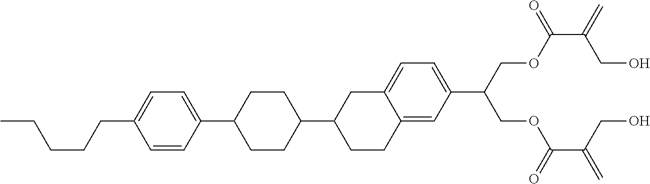 [SMILES: C=C(CO)C(=O)OCC(COC(=O)C(=C)CO)c1ccc2c(c1)CCC(C1CCC(c3ccc(CCCCC)cc3)CC1)C2] |
| 1ϵ-11-56 | 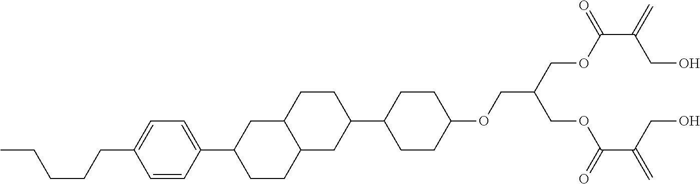 [SMILES: C=C(CO)C(=O)OCC(COC(=O)C(=C)CO)COC1CCC(C2CCC3CC(c4ccc(CCCCC)cc4)CCC3C2)CC1] |
| 1ϵ-11-57 | 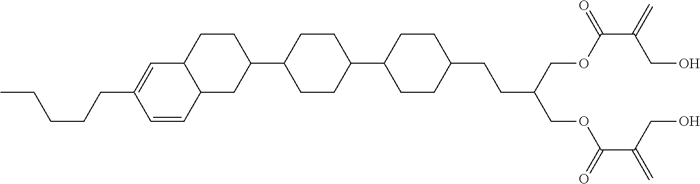 [SMILES: C=C(CO)C(=O)OCC(CCC1CCC(C2CCC(C3CCC4C=C(CCCCC)C=CC4C3)CC2)CC1)COC(=O)C(=C)CO] |
| 1ϵ-11-58 | 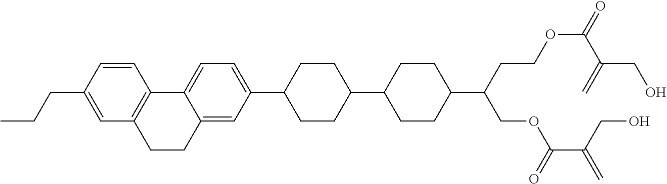 [SMILES: C=C(CO)C(=O)OCCC(COC(=O)C(=C)CO)C1CCC(C2CCC(c3ccc4c(c3)CCc3cc(CCC)ccc3-4)CC2)CC1] |
| 1ϵ-11-59 | 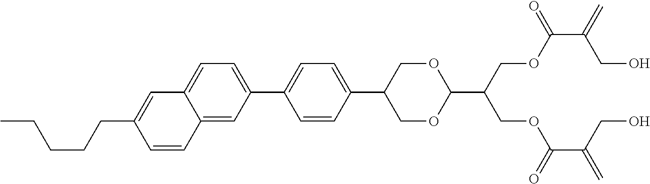 [SMILES: C=C(CO)C(=O)OCC(COC(=O)C(=C)CO)C1OCC(c2ccc(-c3ccc4cc(CCCCC)ccc4c3)cc2)CO1] |
| 1ϵ-11-60 | 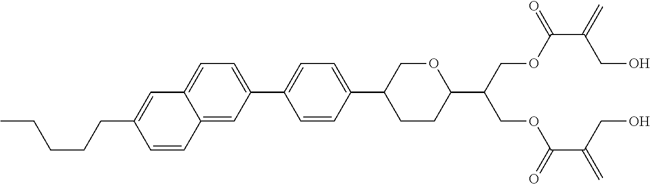 [SMILES: C=C(CO)C(=O)OCC(COC(=O)C(=C)CO)C1CCC(c2ccc(-c3ccc4cc(CCCCC)ccc4c3)cc2)CO1] |
| 1ϵ-11-61 | 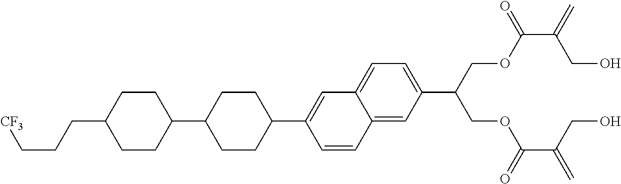 [SMILES: C=C(CO)C(=O)OCC(COC(=O)C(=C)CO)c1ccc2cc(C3CCC(C4CCC(CCCC(F)(F)F)CC4)CC3)ccc2c1] |
| 1ϵ-11-62 | 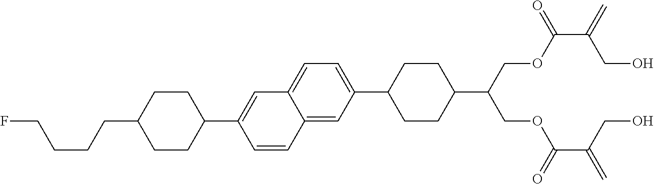 [SMILES: C=C(CO)C(=O)OCC(COC(=O)C(=C)CO)C1CCC(c2ccc3cc(C4CCC(CCCCF)CC4)ccc3c2)CC1] |
| 1ϵ-11-63 | 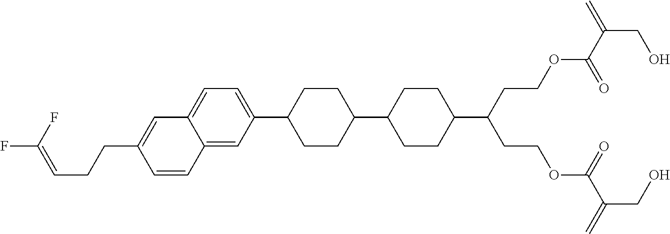 [SMILES: C=C(CO)C(=O)OCCC(CCOC(=O)C(=C)CO)C1CCC(C2CCC(c3ccc4cc(CCC=C(F)F)ccc4c3)CC2)CC1] |
| 1ϵ-11-64 | 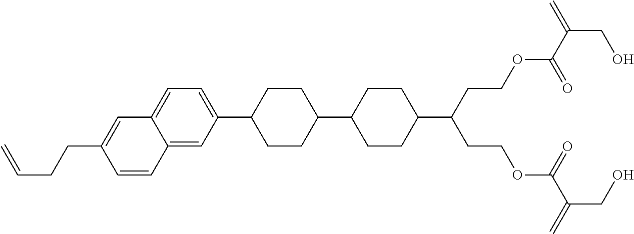 [SMILES: C=CCCc1ccc2cc(C3CCC(C4CCC(C(CCOC(=O)C(=C)CO)CCOC(=O)C(=C)CO)CC4)CC3)ccc2c1] |
| 1ϵ-11-65 | 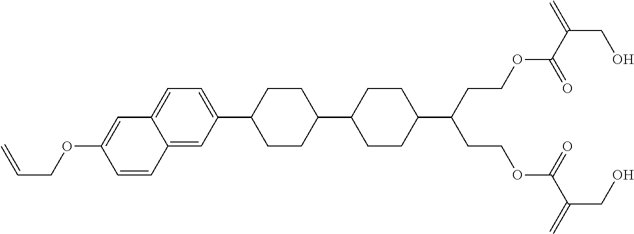 [SMILES: C=CCOc1ccc2cc(C3CCC(C4CCC(C(CCOC(=O)C(=C)CO)CCOC(=O)C(=C)CO)CC4)CC3)ccc2c1] |
| 1ϵ-11-66 | 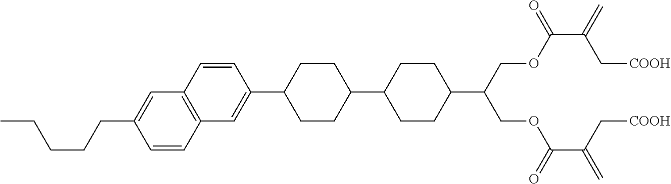 [SMILES: C=C(CC(=O)O)C(=O)OCC(COC(=O)C(=C)CC(=O)O)C1CCC(C2CCC(c3ccc4cc(CCCCC)ccc4c3)CC2)CC1] |
| 1ϵ-11-67 | 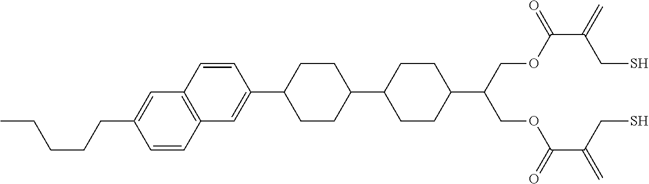 [SMILES: C=C(CS)C(=O)OCC(COC(=O)C(=C)CS)C1CCC(C2CCC(c3ccc4cc(CCCCC)ccc4c3)CC2)CC1] |
| 1ϵ-11-68 | 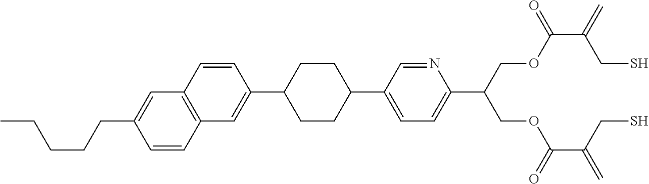 [SMILES: C=C(CS)C(=O)OCC(COC(=O)C(=C)CS)c1ccc(C2CCC(c3ccc4cc(CCCCC)ccc4c3)CC2)cn1] |
| 1ϵ-11-69 | 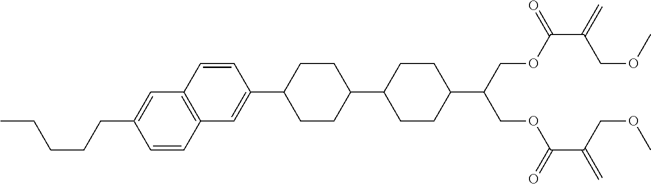 [SMILES: C=C(COC)C(=O)OCC(COC(=O)C(=C)COC)C1CCC(C2CCC(c3ccc4cc(CCCCC)ccc4c3)CC2)CC1] |
| 1ϵ-11-70 | 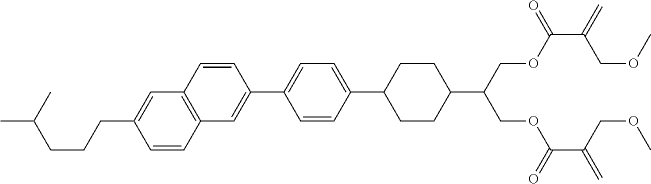 [SMILES: C=C(COC)C(=O)OCC(COC(=O)C(=C)COC)C1CCC(c2ccc(-c3ccc4cc(CCCC(C)C)ccc4c3)cc2)CC1] |
| 1ϵ-11-71 | 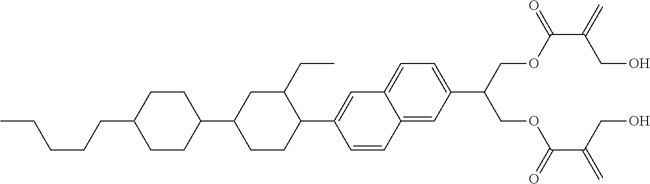 [SMILES: C=C(CO)C(=O)OCC(COC(=O)C(=C)CO)c1ccc2cc(C3CCC(C4CCC(CCCCC)CC4)CC3CC)ccc2c1] |
| 1ϵ-11-72 | 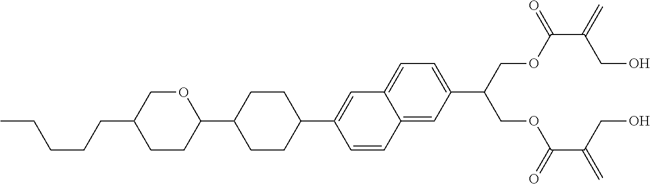 [SMILES: C=C(CO)C(=O)OCC(COC(=O)C(=C)CO)c1ccc2cc(C3CCC(C4CCC(CCCCC)CO4)CC3)ccc2c1] |
| 1ϵ-11-73 | 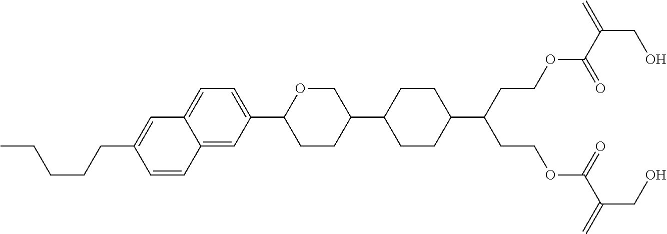 [SMILES: C=C(CO)C(=O)OCCC(CCOC(=O)C(=C)CO)C1CCC(C2CCC(c3ccc4cc(CCCCC)ccc4c3)OC2)CC1] |
| 1ϵ-11-74 | 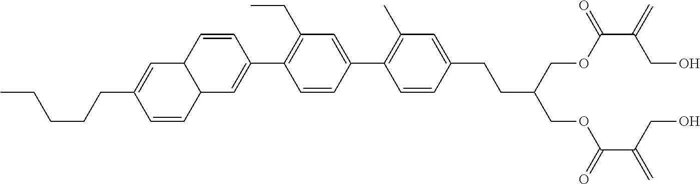 [SMILES: C=C(CO)C(=O)OCC(CCc1ccc(-c2ccc(C3=CC4C=CC(CCCCC)=CC4C=C3)c(CC)c2)c(C)c1)COC(=O)C(=C)CO] |
| 1ϵ-11-75 | 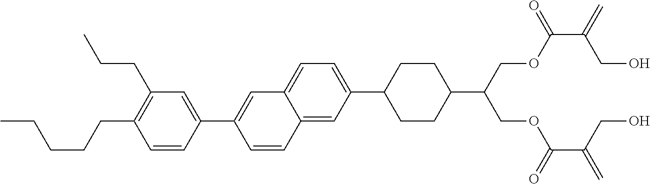 [SMILES: C=C(CO)C(=O)OCC(COC(=O)C(=C)CO)C1CCC(c2ccc3cc(-c4ccc(CCCCC)c(CCC)c4)ccc3c2)CC1] |
| 1ϵ-11-76 | 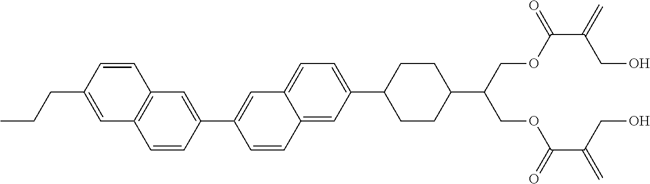 [SMILES: C=C(CO)C(=O)OCC(COC(=O)C(=C)CO)C1CCC(c2ccc3cc(-c4ccc5cc(CCC)ccc5c4)ccc3c2)CC1] |
| 1ϵ-11-77 | 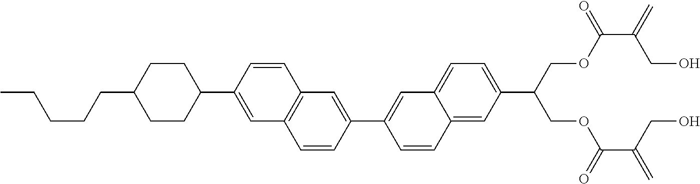 [SMILES: C=C(CO)C(=O)OCC(COC(=O)C(=C)CO)c1ccc2cc(-c3ccc4cc(C5CCC(CCCCC)CC5)ccc4c3)ccc2c1] |
| 1ϵ-11-78 | 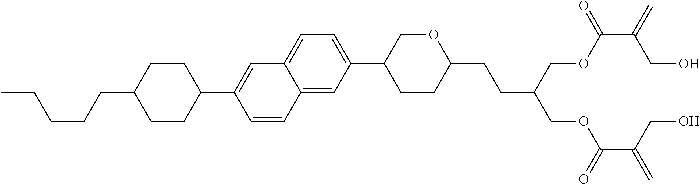 [SMILES: C=C(CO)C(=O)OCC(CCC1CCC(c2ccc3cc(C4CCC(CCCCC)CC4)ccc3c2)CO1)COC(=O)C(=C)CO] |
| 1ϵ-11-79 | 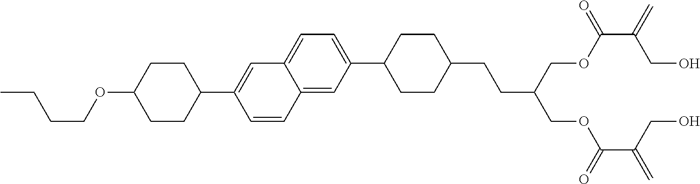 [SMILES: C=C(CO)C(=O)OCC(CCC1CCC(c2ccc3cc(C4CCC(OCCCC)CC4)ccc3c2)CC1)COC(=O)C(=C)CO] |
| 1ϵ-11-80 | 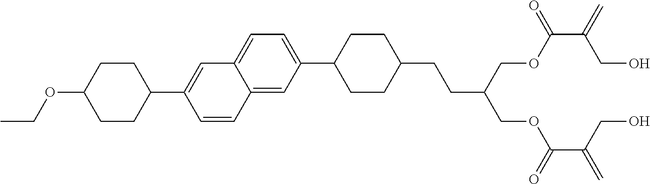 [SMILES: C=C(CO)C(=O)OCC(CCC1CCC(c2ccc3cc(C4CCC(OCC)CC4)ccc3c2)CC1)COC(=O)C(=C)CO] |
| 1ϵ-11-81 | 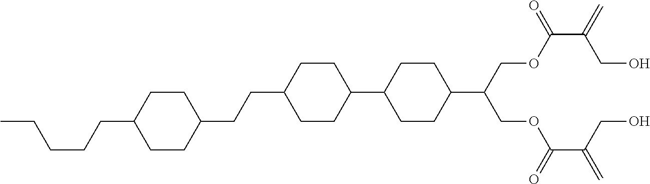 [SMILES: C=C(CO)C(=O)OCC(COC(=O)C(=C)CO)C1CCC(C2CCC(CCC3CCC(CCCCC)CC3)CC2)CC1] |
| 1ϵ-11-82 | 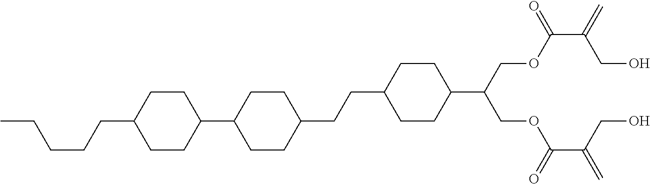 [SMILES: C=C(CO)C(=O)OCC(COC(=O)C(=C)CO)C1CCC(CCC2CCC(C3CCC(CCCCC)CC3)CC2)CC1] |
| 1ϵ-11-83 | 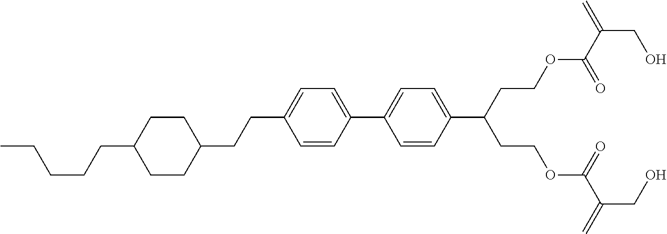 [SMILES: C=C(CO)C(=O)OCCC(CCOC(=O)C(=C)CO)c1ccc(-c2ccc(CCC3CCC(CCCCC)CC3)cc2)cc1] |
| 1ϵ-11-84 | 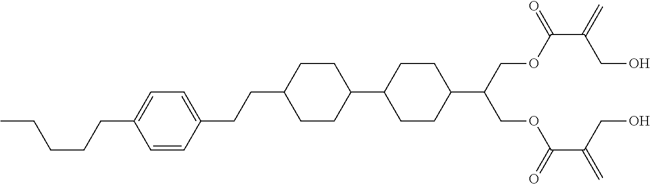 [SMILES: C=C(CO)C(=O)OCC(COC(=O)C(=C)CO)C1CCC(C2CCC(CCc3ccc(CCCCC)cc3)CC2)CC1] |
| 1ϵ-11-85 | 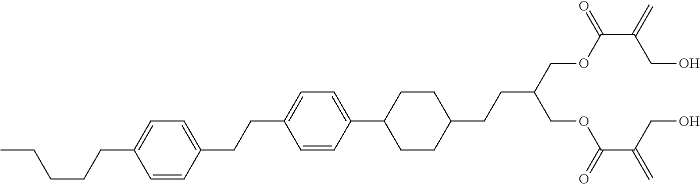 [SMILES: C=C(CO)C(=O)OCC(CCC1CCC(c2ccc(CCc3ccc(CCCCC)cc3)cc2)CC1)COC(=O)C(=C)CO] |
| 1ϵ-11-86 | 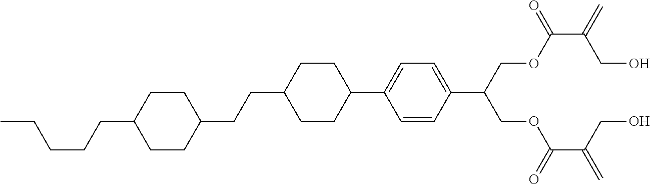 [SMILES: C=C(CO)C(=O)OCC(COC(=O)C(=C)CO)c1ccc(C2CCC(CCC3CCC(CCCCC)CC3)CC2)cc1] |
| 1ϵ-11-87 | 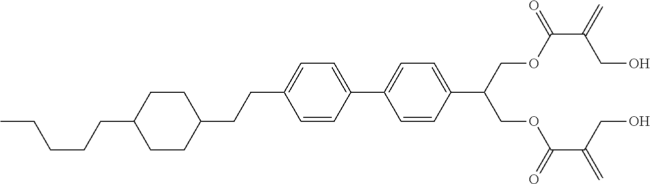 [SMILES: C=C(CO)C(=O)OCC(COC(=O)C(=C)CO)c1ccc(-c2ccc(CCC3CCC(CCCCC)CC3)cc2)cc1] |
| 1ϵ-11-88 | 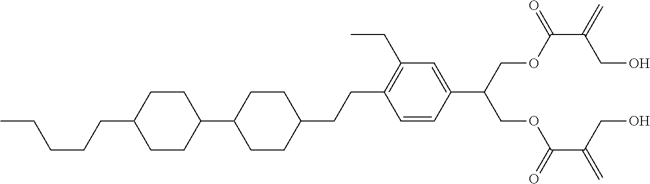 [SMILES: C=C(CO)C(=O)OCC(COC(=O)C(=C)CO)c1ccc(CCC2CCC(C3CCC(CCCCC)CC3)CC2)c(CC)c1] |
| 1ϵ-11-89 | 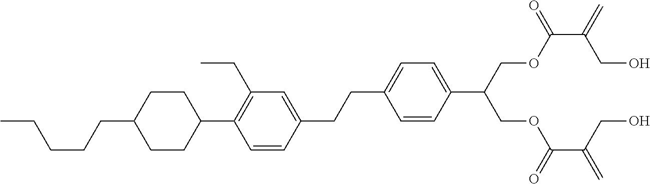 [SMILES: C=C(CO)C(=O)OCC(COC(=O)C(=C)CO)c1ccc(CCc2ccc(C3CCC(CCCCC)CC3)c(CC)c2)cc1] |
| 1ϵ-11-90 | 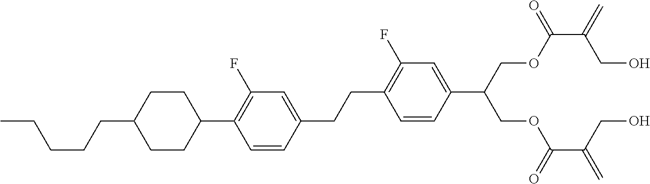 [SMILES: C=C(CO)C(=O)OCC(COC(=O)C(=C)CO)c1ccc(CCc2ccc(C3CCC(CCCCC)CC3)c(F)c2)c(F)c1] |
| 1ϵ-11-91 | 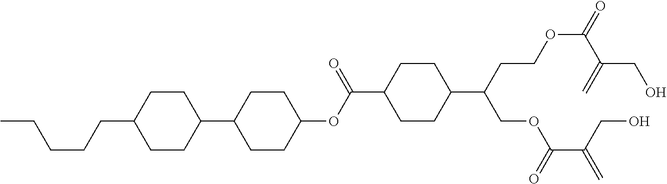 [SMILES: C=C(CO)C(=O)OCCC(COC(=O)C(=C)CO)C1CCC(C(=O)OC2CCC(C3CCC(CCCCC)CC3)CC2)CC1] |
| 1ϵ-11-92 | 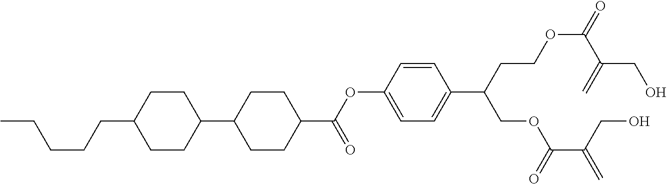 [SMILES: C=C(CO)C(=O)OCCC(COC(=O)C(=C)CO)c1ccc(OC(=O)C2CCC(C3CCC(CCCCC)CC3)CC2)cc1] |
| 1ϵ-11-93 | 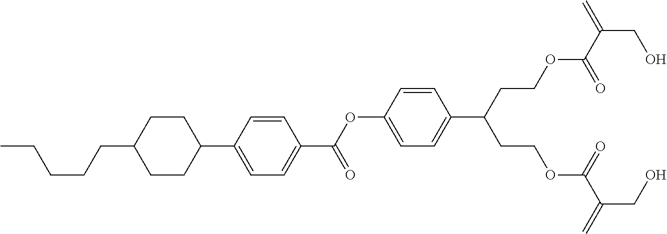 [SMILES: C=C(CO)C(=O)OCCC(CCOC(=O)C(=C)CO)c1ccc(OC(=O)c2ccc(C3CCC(CCCCC)CC3)cc2)cc1] |
| 1ϵ-11-94 | 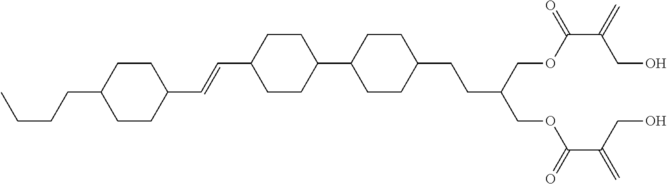 [SMILES: C=C(CO)C(=O)OCC(CCC1CCC(C2CCC(/C=C/C3CCC(CCCC)CC3)CC2)CC1)COC(=O)C(=C)CO] |
| 1ϵ-11-95 | 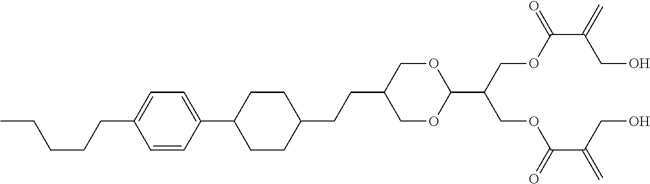 [SMILES: C=C(CO)C(=O)OCC(COC(=O)C(=C)CO)C1OCC(CCC2CCC(c3ccc(CCCCC)cc3)CC2)CO1] |
| 1ϵ-11-96 | 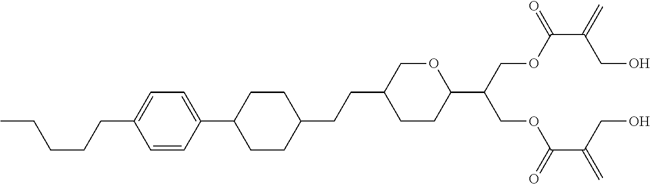 [SMILES: C=C(CO)C(=O)OCC(COC(=O)C(=C)CO)C1CCC(CCC2CCC(c3ccc(CCCCC)cc3)CC2)CO1] |
| 1ϵ-11-97 | 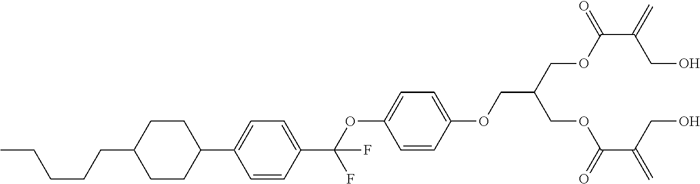 [SMILES: C=C(CO)C(=O)OCC(COC(=O)C(=C)CO)COc1ccc(OC(F)(F)c2ccc(C3CCC(CCCCC)CC3)cc2)cc1] |
| 1ϵ-11-98 | 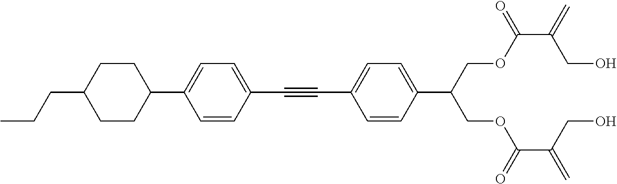 [SMILES: C=C(CO)C(=O)OCC(COC(=O)C(=C)CO)c1ccc(C#Cc2ccc(C3CCC(CCC)CC3)cc2)cc1] |
| 1ϵ-11-99 | 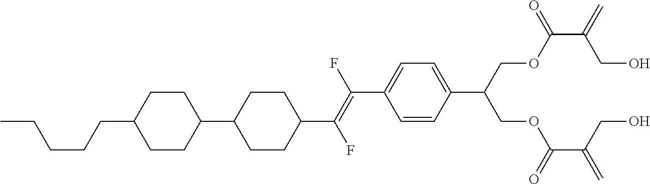 [SMILES: C=C(CO)C(=O)OCC(COC(=O)C(=C)CO)c1ccc(/C(F)=C(\F)C2CCC(C3CCC(CCCCC)CC3)CC2)cc1] |
| 1ϵ-11-100 | 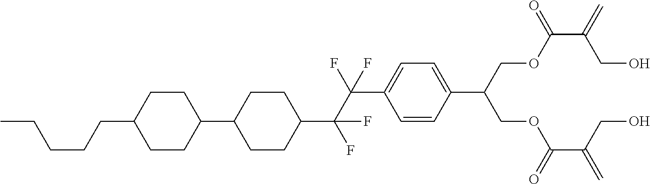 [SMILES: C=C(CO)C(=O)OCC(COC(=O)C(=C)CO)c1ccc(C(F)(F)C(F)(F)C2CCC(C3CCC(CCCCC)CC3)CC2)cc1] |
| 1ϵ-11-101 | 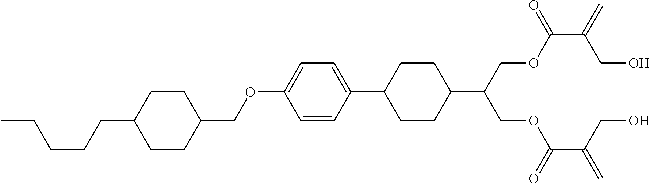 [SMILES: C=C(CO)C(=O)OCC(COC(=O)C(=C)CO)C1CCC(c2ccc(OCC3CCC(CCCCC)CC3)cc2)CC1] |
| 1ϵ-11-102 | 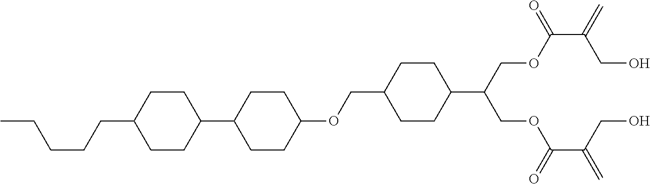 [SMILES: C=C(CO)C(=O)OCC(COC(=O)C(=C)CO)C1CCC(COC2CCC(C3CCC(CCCCC)CC3)CC2)CC1] |
| 1ϵ-11-103 | 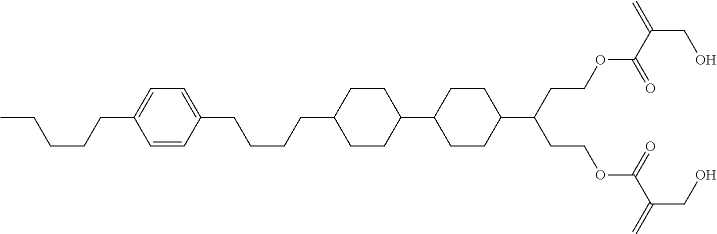 [SMILES: C=C(CO)C(=O)OCCC(CCOC(=O)C(=C)CO)C1CCC(C2CCC(CCCCc3ccc(CCCCC)cc3)CC2)CC1] |
| 1ϵ-11-104 | 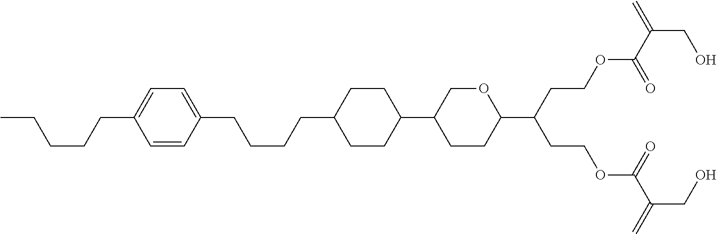 [SMILES: C=C(CO)C(=O)OCCC(CCOC(=O)C(=C)CO)C1CCC(C2CCC(CCCCc3ccc(CCCCC)cc3)CC2)CO1] |
| 1ϵ-11-105 | 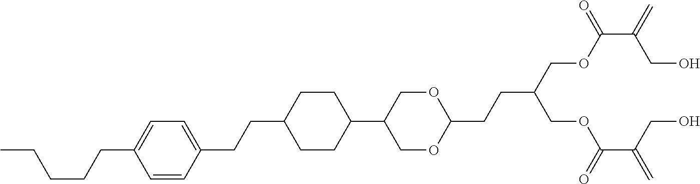 [SMILES: C=C(CO)C(=O)OCC(CCC1OCC(C2CCC(CCc3ccc(CCCCC)cc3)CC2)CO1)COC(=O)C(=C)CO] |
| 1ϵ-11-106 | 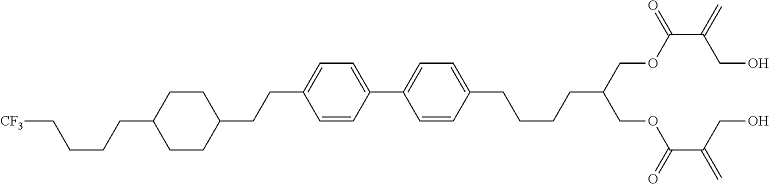 [SMILES: C=C(CO)C(=O)OCC(CCCCc1ccc(-c2ccc(CCC3CCC(CCCCC(F)(F)F)CC3)cc2)cc1)COC(=O)C(=C)CO] |
| 1ϵ-11-107 | 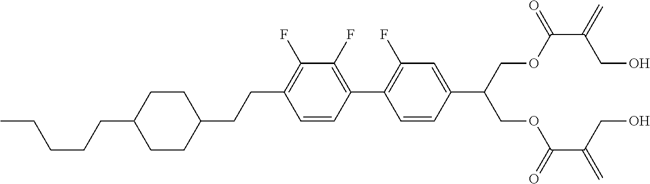 [SMILES: C=C(CO)C(=O)OCC(COC(=O)C(=C)CO)c1ccc(-c2ccc(CCC3CCC(CCCCC)CC3)c(F)c2F)c(F)c1] |
| 1ϵ-11-108 | 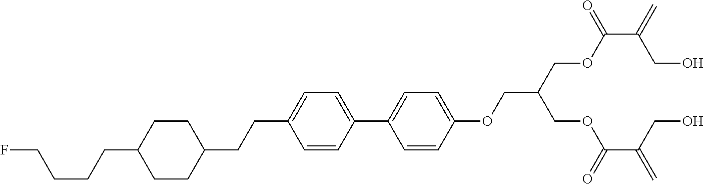 [SMILES: C=C(CO)C(=O)OCC(COC(=O)C(=C)CO)COc1ccc(-c2ccc(CCC3CCC(CCCCF)CC3)cc2)cc1] |
| 1ϵ-11-109 | 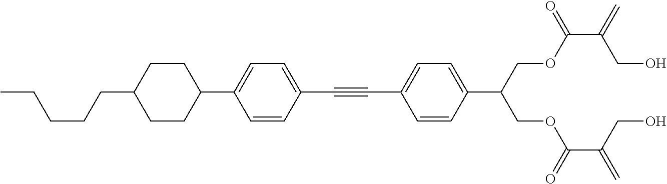 [SMILES: C=C(CO)C(=O)OCC(COC(=O)C(=C)CO)c1ccc(C#Cc2ccc(C3CCC(CCCCC)CC3)cc2)cc1] |
| 1ϵ-11-110 | 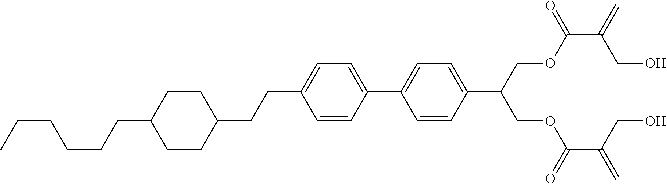 [SMILES: C=C(CO)C(=O)OCC(COC(=O)C(=C)CO)c1ccc(-c2ccc(CCC3CCC(CCCCCC)CC3)cc2)cc1] |
| 1ϵ-11-111 | 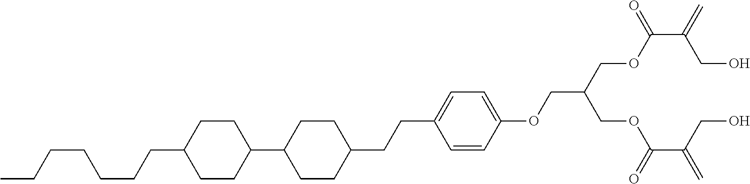 [SMILES: C=C(CO)C(=O)OCC(COC(=O)C(=C)CO)COc1ccc(CCC2CCC(C3CCC(CCCCCCC)CC3)CC2)cc1] |
| 1ϵ-11-112 | 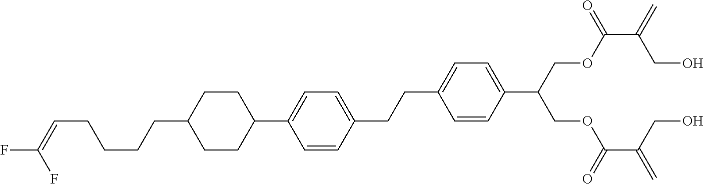 [SMILES: C=C(CO)C(=O)OCC(COC(=O)C(=C)CO)c1ccc(CCc2ccc(C3CCC(CCCCC=C(F)F)CC3)cc2)cc1] |
| 1ϵ-11-113 | 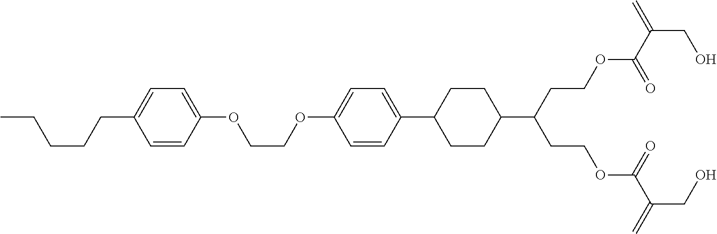 [SMILES: C=C(CO)C(=O)OCCC(CCOC(=O)C(=C)CO)C1CCC(c2ccc(OCCOc3ccc(CCCCC)cc3)cc2)CC1] |
| 1ϵ-11-114 | 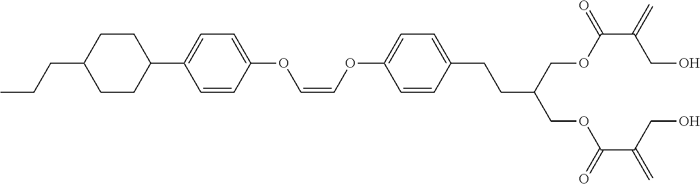 [SMILES: C=C(CO)C(=O)OCC(CCc1ccc(O/C=C\Oc2ccc(C3CCC(CCC)CC3)cc2)cc1)COC(=O)C(=C)CO] |
| 1ϵ-11-115 | 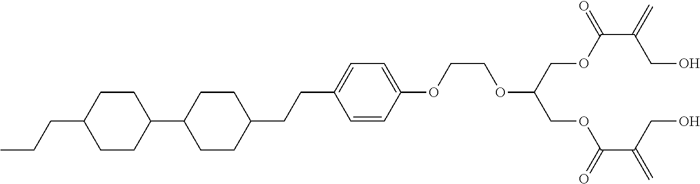 [SMILES: C=C(CO)C(=O)OCC(COC(=O)C(=C)CO)OCCOc1ccc(CCC2CCC(C3CCC(CCC)CC3)CC2)cc1] |
| 1ϵ-11-116 | 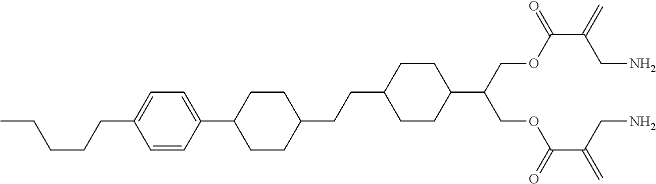 [SMILES: C=C(CN)C(=O)OCC(COC(=O)C(=C)CN)C1CCC(CCC2CCC(c3ccc(CCCCC)cc3)CC2)CC1] |
| 1ϵ-11-117 | 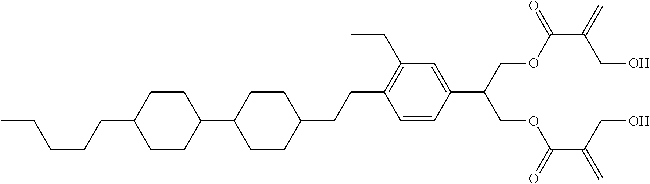 [SMILES: C=C(CO)C(=O)OCC(COC(=O)C(=C)CO)c1ccc(CCC2CCC(C3CCC(CCCCC)CC3)CC2)c(CC)c1] |
| 1ϵ-11-118 | 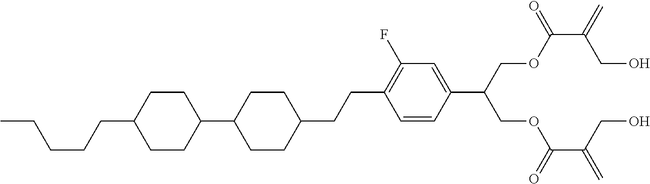 [SMILES: C=C(CO)C(=O)OCC(COC(=O)C(=C)CO)c1ccc(CCC2CCC(C3CCC(CCCCC)CC3)CC2)c(F)c1] |
| 1ϵ-11-119 | 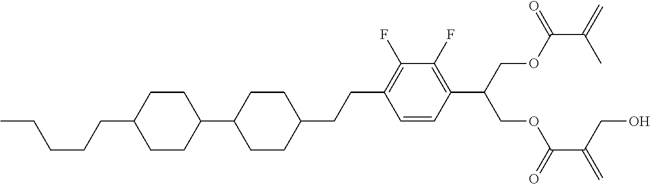 [SMILES: C=C(C)C(=O)OCC(COC(=O)C(=C)CO)c1ccc(CCC2CCC(C3CCC(CCCCC)CC3)CC2)c(F)c1F] |
| 1ϵ-11-120 | 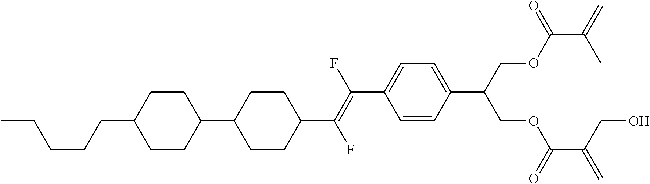 [SMILES: C=C(C)C(=O)OCC(COC(=O)C(=C)CO)c1ccc(/C(F)=C(\F)C2CCC(C3CCC(CCCCC)CC3)CC2)cc1] |
| 1ϵ-11-121 | 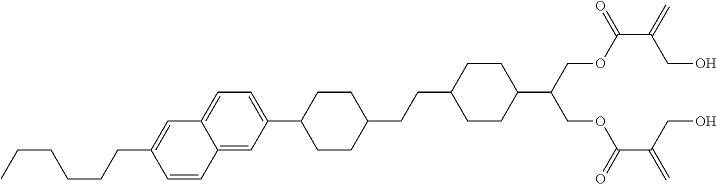 [SMILES: C=C(CO)C(=O)OCC(COC(=O)C(=C)CO)C1CCC(CCC2CCC(c3ccc4cc(CCCCCC)ccc4c3)CC2)CC1] |
| 1ϵ-11-122 | 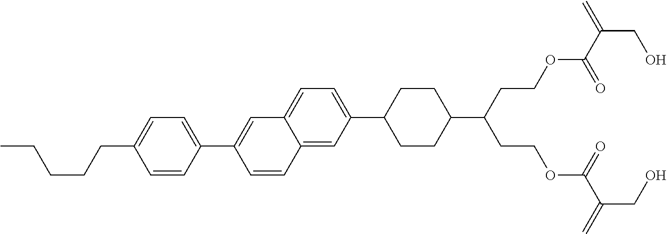 [SMILES: C=C(CO)C(=O)OCCC(CCOC(=O)C(=C)CO)C1CCC(c2ccc3cc(-c4ccc(CCCCC)cc4)ccc3c2)CC1] |
| 1ϵ-11-123 | 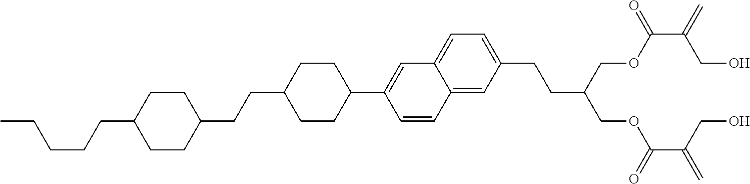 [SMILES: C=C(CO)C(=O)OCC(CCc1ccc2cc(C3CCC(CCC4CCC(CCCCC)CC4)CC3)ccc2c1)COC(=O)C(=C)CO] |
| 1ϵ-11-124 | 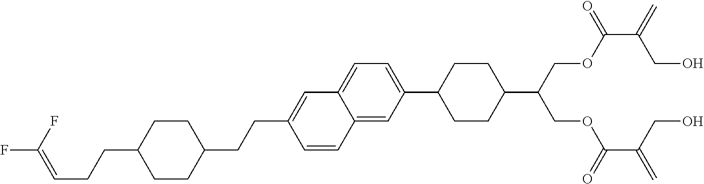 [SMILES: C=C(CO)C(=O)OCC(COC(=O)C(=C)CO)C1CCC(c2ccc3cc(CCC4CCC(CCC=C(F)F)CC4)ccc3c2)CC1] |
| 1ϵ-11-125 | 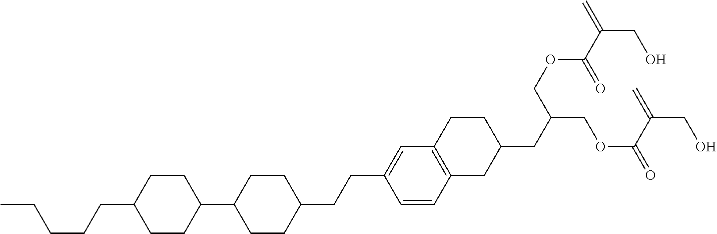 [SMILES: C=C(CO)C(=O)OCC(COC(=O)C(=C)CO)CC1CCc2cc(CCC3CCC(C4CCC(CCCCC)CC4)CC3)ccc2C1] |
| 1ϵ-11-126 | 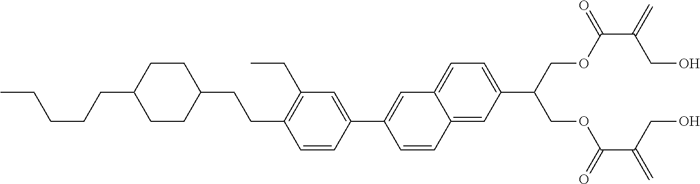 [SMILES: C=C(CO)C(=O)OCC(COC(=O)C(=C)CO)c1ccc2cc(-c3ccc(CCC4CCC(CCCCC)CC4)c(CC)c3)ccc2c1] |
| 1ϵ-11-127 | 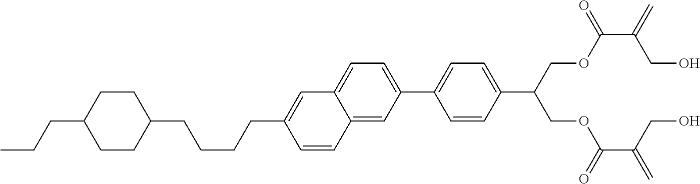 [SMILES: C=C(CO)C(=O)OCC(COC(=O)C(=C)CO)c1ccc(-c2ccc3cc(CCCCC4CCC(CCC)CC4)ccc3c2)cc1] |
| 1ϵ-11-128 | 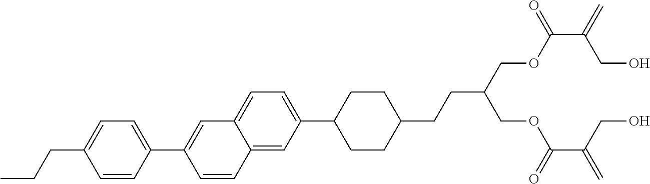 [SMILES: C=C(CO)C(=O)OCC(CCC1CCC(c2ccc3cc(-c4ccc(CCC)cc4)ccc3c2)CC1)COC(=O)C(=C)CO] |
| 1ϵ-11-129 | 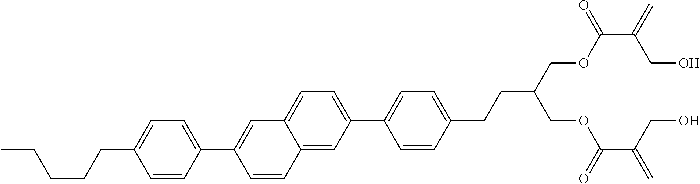 [SMILES: C=C(CO)C(=O)OCC(CCc1ccc(-c2ccc3cc(-c4ccc(CCCCC)cc4)ccc3c2)cc1)COC(=O)C(=C)CO] |
| 1ϵ-11-130 | 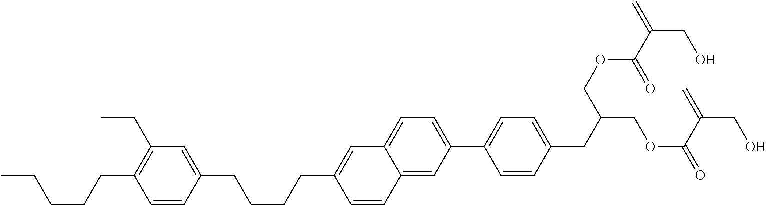 [SMILES: C=C(CO)C(=O)OCC(COC(=O)C(=C)CO)Cc1ccc(-c2ccc3cc(CCCCc4ccc(CCCCC)c(CC)c4)ccc3c2)cc1] |
| 1ϵ-11-131 | 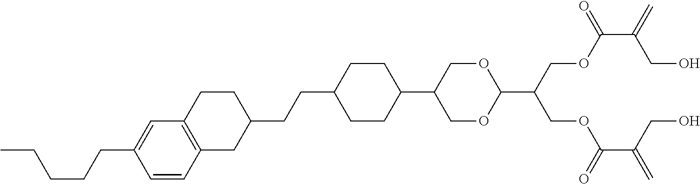 [SMILES: C=C(CO)C(=O)OCC(COC(=O)C(=C)CO)C1OCC(C2CCC(CCC3CCc4cc(CCCCC)ccc4C3)CC2)CO1] |
| 1ϵ-11-132 | 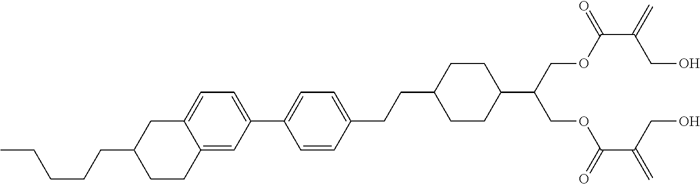 [SMILES: C=C(CO)C(=O)OCC(COC(=O)C(=C)CO)C1CCC(CCc2ccc(-c3ccc4c(c3)CCC(CCCCC)C4)cc2)CC1] |
| 1ϵ-11-133 | 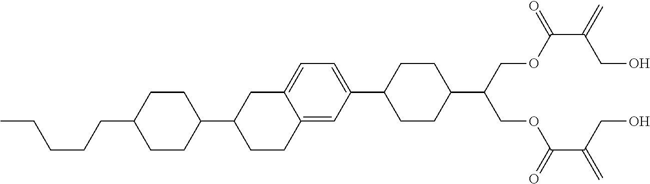 [SMILES: C=C(CO)C(=O)OCC(COC(=O)C(=C)CO)C1CCC(c2ccc3c(c2)CCC(C2CCC(CCCCC)CC2)C3)CC1] |
| 1ϵ-11-134 | 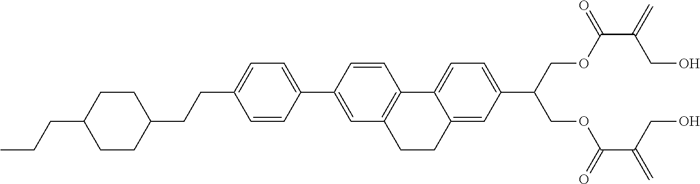 [SMILES: C=C(CO)C(=O)OCC(COC(=O)C(=C)CO)c1ccc2c(c1)CCc1cc(-c3ccc(CCC4CCC(CCC)CC4)cc3)ccc1-2] |
| 1ϵ-11-135 | 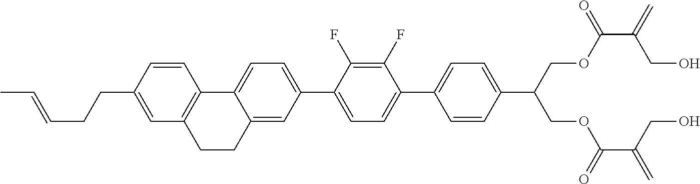 [SMILES: C=C(CO)C(=O)OCC(COC(=O)C(=C)CO)c1ccc(-c2ccc(-c3ccc4c(c3)CCc3cc(CC/C=C/C)ccc3-4)c(F)c2F)cc1] |
| 1ϵ-11-136 | 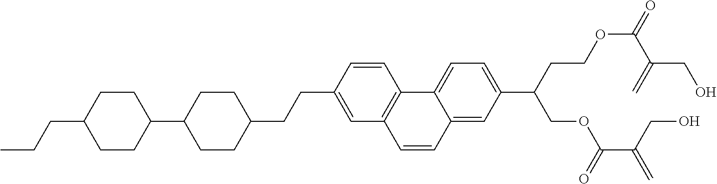 [SMILES: C=C(CO)C(=O)OCCC(COC(=O)C(=C)CO)c1ccc2c(ccc3cc(CCC4CCC(C5CCC(CCC)CC5)CC4)ccc32)c1] |
| 1ϵ-11-137 | 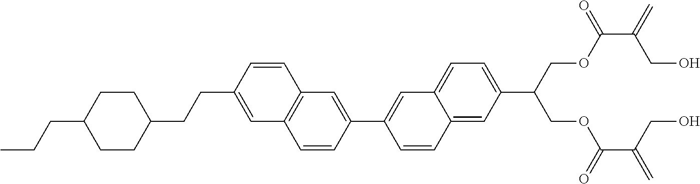 [SMILES: C=C(CO)C(=O)OCC(COC(=O)C(=C)CO)c1ccc2cc(-c3ccc4cc(CCC5CCC(CCC)CC5)ccc4c3)ccc2c1] |
| 1ϵ-11-138 | 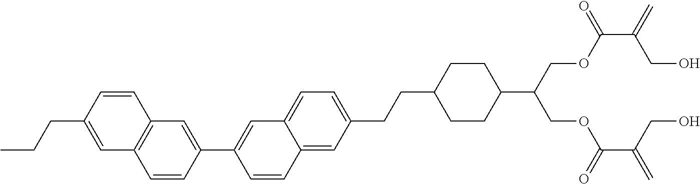 [SMILES: C=C(CO)C(=O)OCC(COC(=O)C(=C)CO)C1CCC(CCc2ccc3cc(-c4ccc5cc(CCC)ccc5c4)ccc3c2)CC1] |
| 1ϵ-11-139 | 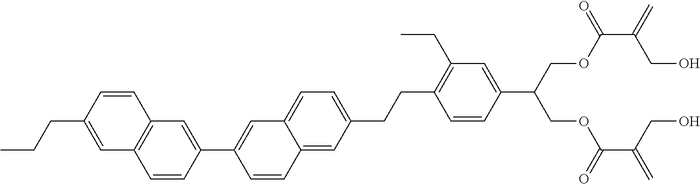 [SMILES: C=C(CO)C(=O)OCC(COC(=O)C(=C)CO)c1ccc(CCc2ccc3cc(-c4ccc5cc(CCC)ccc5c4)ccc3c2)c(CC)c1] |
| 1ϵ-11-140 | 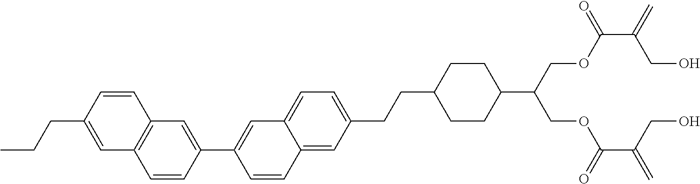 [SMILES: C=C(CO)C(=O)OCC(COC(=O)C(=C)CO)C1CCC(CCc2ccc3cc(-c4ccc5cc(CCC)ccc5c4)ccc3c2)CC1] |
| 1ϵ-12-1 | 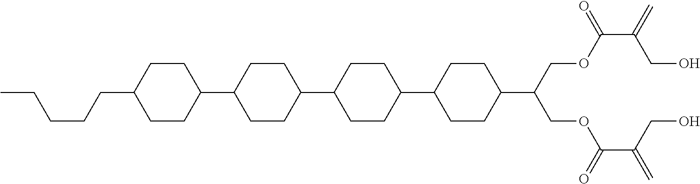 [SMILES: C=C(CO)C(=O)OCC(COC(=O)C(=C)CO)C1CCC(C2CCC(C3CCC(C4CCC(CCCCC)CC4)CC3)CC2)CC1] |
| 1ϵ-12-2 | 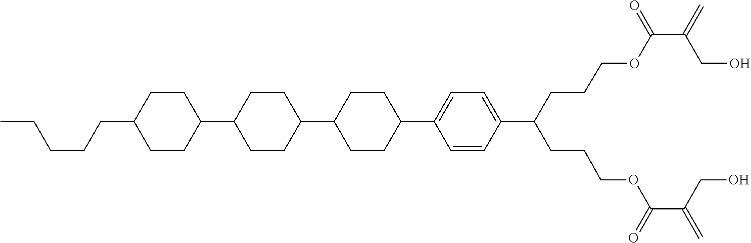 [SMILES: C=C(CO)C(=O)OCCCC(CCCOC(=O)C(=C)CO)c1ccc(C2CCC(C3CCC(C4CCC(CCCCC)CC4)CC3)CC2)cc1] |
| 1ϵ-12-3 | 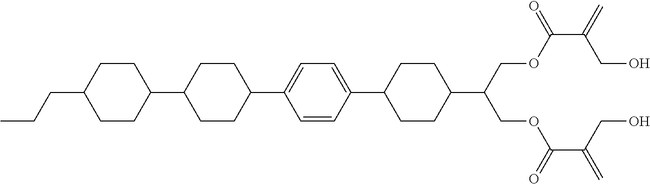 [SMILES: C=C(CO)C(=O)OCC(COC(=O)C(=C)CO)C1CCC(c2ccc(C3CCC(C4CCC(CCC)CC4)CC3)cc2)CC1] |
| 1ϵ-12-4 | 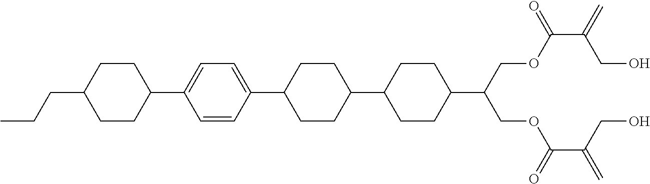 [SMILES: C=C(CO)C(=O)OCC(COC(=O)C(=C)CO)C1CCC(C2CCC(c3ccc(C4CCC(CCC)CC4)cc3)CC2)CC1] |
| 1ϵ-12-5 | 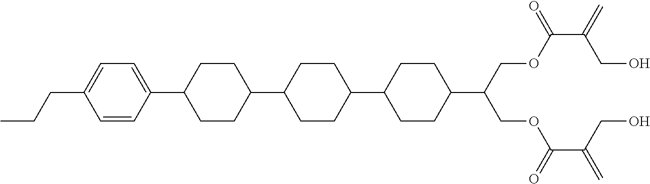 [SMILES: C=C(CO)C(=O)OCC(COC(=O)C(=C)CO)C1CCC(C2CCC(C3CCC(c4ccc(CCC)cc4)CC3)CC2)CC1] |
| 1ϵ-12-6 | 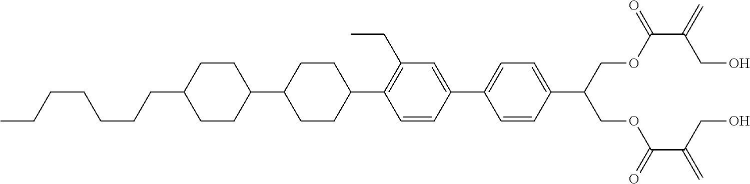 [SMILES: C=C(CO)C(=O)OCC(COC(=O)C(=C)CO)c1ccc(-c2ccc(C3CCC(C4CCC(CCCCCCC)CC4)CC3)c(CC)c2)cc1] |
| 1ϵ-12-7 | 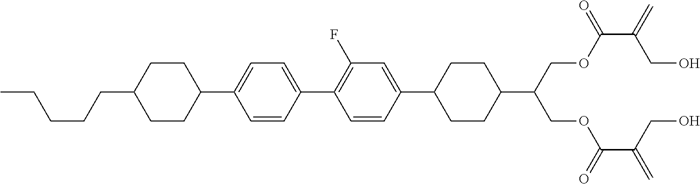 [SMILES: C=C(CO)C(=O)OCC(COC(=O)C(=C)CO)C1CCC(c2ccc(-c3ccc(C4CCC(CCCCC)CC4)cc3)c(F)c2)CC1] |
| 1ϵ-12-8 | 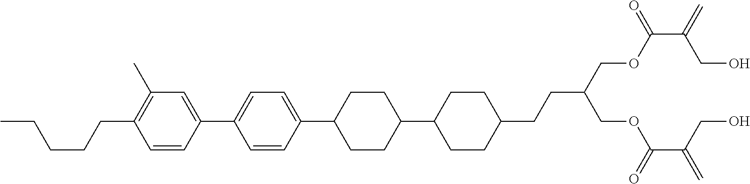 [SMILES: C=C(CO)C(=O)OCC(CCC1CCC(C2CCC(c3ccc(-c4ccc(CCCCC)c(C)c4)cc3)CC2)CC1)COC(=O)C(=C)CO] |
| 1ϵ-12-9 | 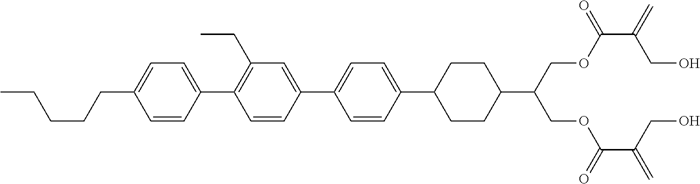 [SMILES: C=C(CO)C(=O)OCC(COC(=O)C(=C)CO)C1CCC(c2ccc(-c3ccc(-c4ccc(CCCCC)cc4)c(CC)c3)cc2)CC1] |
| 1ϵ-12-10 | 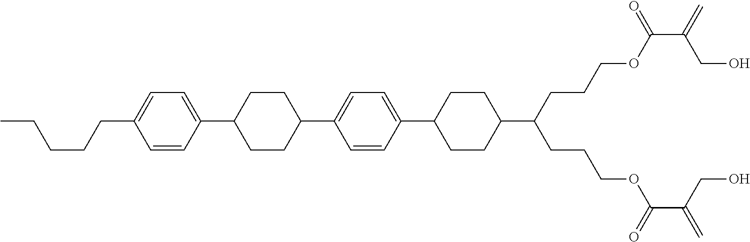 [SMILES: C=C(CO)C(=O)OCCCC(CCCOC(=O)C(=C)CO)C1CCC(c2ccc(C3CCC(c4ccc(CCCCC)cc4)CC3)cc2)CC1] |
| 1ϵ-12-11 | 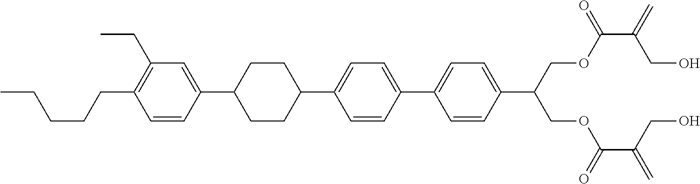 [SMILES: C=C(CO)C(=O)OCC(COC(=O)C(=C)CO)c1ccc(-c2ccc(C3CCC(c4ccc(CCCCC)c(CC)c4)CC3)cc2)cc1] |
| 1ϵ-12-12 | 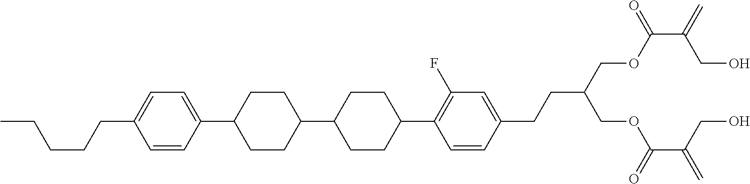 [SMILES: C=C(CO)C(=O)OCC(CCc1ccc(C2CCC(C3CCC(c4ccc(CCCCC)cc4)CC3)CC2)c(F)c1)COC(=O)C(=C)CO] |
| 1ϵ-12-13 | 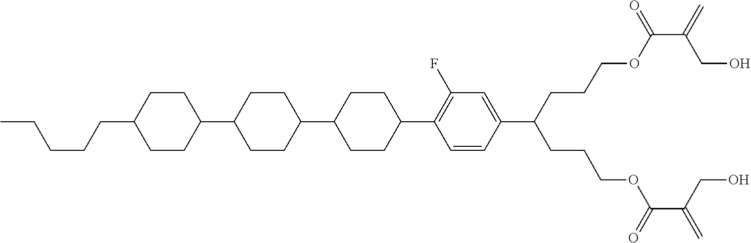 [SMILES: C=C(CO)C(=O)OCCCC(CCCOC(=O)C(=C)CO)c1ccc(C2CCC(C3CCC(C4CCC(CCCCC)CC4)CC3)CC2)c(F)c1] |
| 1ϵ-12-14 | 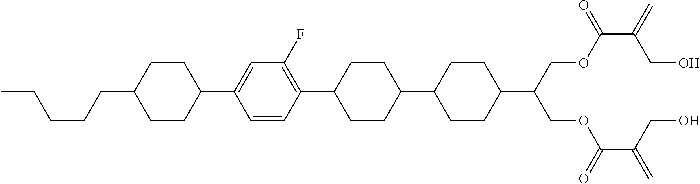 [SMILES: C=C(CO)C(=O)OCC(COC(=O)C(=C)CO)C1CCC(C2CCC(c3ccc(C4CCC(CCCCC)CC4)cc3F)CC2)CC1] |
| 1ϵ-12-15 | 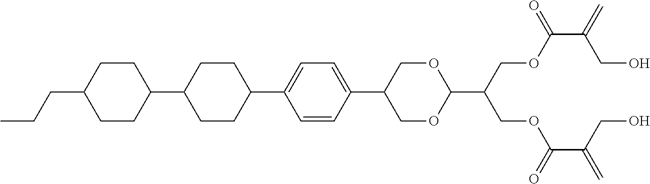 [SMILES: C=C(CO)C(=O)OCC(COC(=O)C(=C)CO)C1OCC(c2ccc(C3CCC(C4CCC(CCC)CC4)CC3)cc2)CO1] |
| 1ϵ-12-16 | 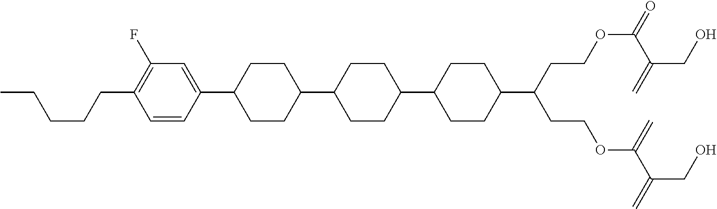 [SMILES: C=C(CO)C(=C)OCCC(CCOC(=O)C(=C)CO)C1CCC(C2CCC(C3CCC(c4ccc(CCCCC)c(F)c4)CC3)CC2)CC1] |
| 1ϵ-12-17 | 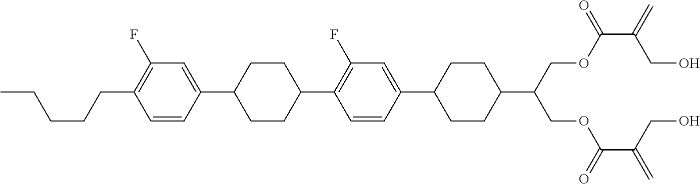 [SMILES: C=C(CO)C(=O)OCC(COC(=O)C(=C)CO)C1CCC(c2ccc(C3CCC(c4ccc(CCCCC)c(F)c4)CC3)c(F)c2)CC1] |
| 1ϵ-12-18 | 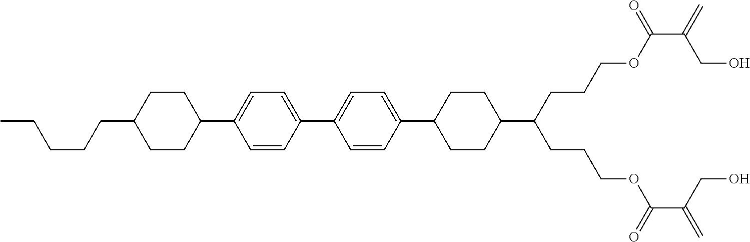 [SMILES: C=C(CO)C(=O)OCCCC(CCCOC(=O)C(=C)CO)C1CCC(c2ccc(-c3ccc(C4CCC(CCCCC)CC4)cc3)cc2)CC1] |
| 1ϵ-12-19 | 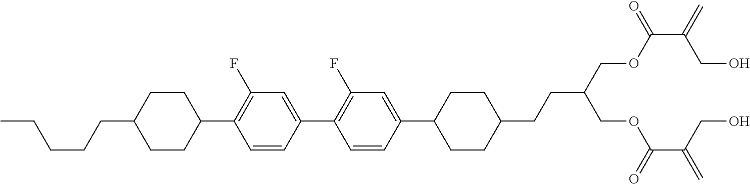 [SMILES: C=C(CO)C(=O)OCC(CCC1CCC(c2ccc(-c3ccc(C4CCC(CCCCC)CC4)c(F)c3)c(F)c2)CC1)COC(=O)C(=C)CO] |
| 1ϵ-12-20 | 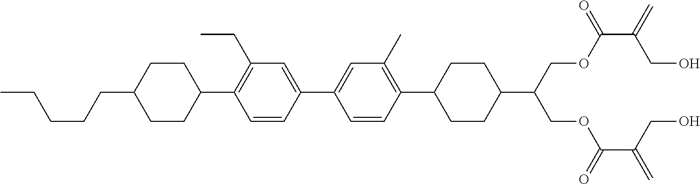 [SMILES: C=C(CO)C(=O)OCC(COC(=O)C(=C)CO)C1CCC(c2ccc(-c3ccc(C4CCC(CCCCC)CC4)c(CC)c3)cc2C)CC1] |
| 1ϵ-12-21 | 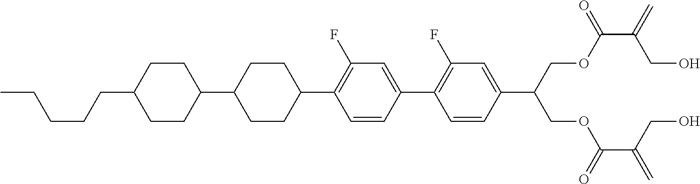 [SMILES: C=C(CO)C(=O)OCC(COC(=O)C(=C)CO)c1ccc(-c2ccc(C3CCC(C4CCC(CCCCC)CC4)CC3)c(F)c2)c(F)c1] |
| 1ϵ-12-22 | 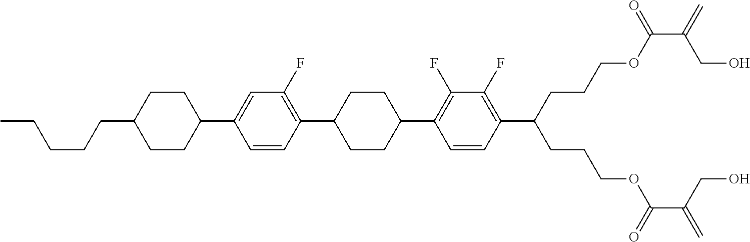 [SMILES: C=C(CO)C(=O)OCCCC(CCCOC(=O)C(=C)CO)c1ccc(C2CCC(c3ccc(C4CCC(CCCCC)CC4)cc3F)CC2)c(F)c1F] |
| 1ϵ-12-23 | 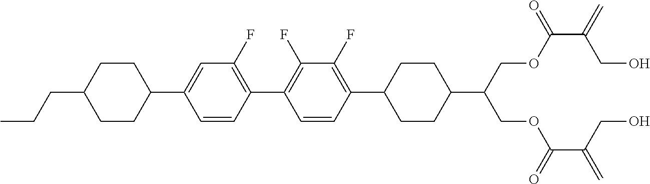 [SMILES: C=C(CO)C(=O)OCC(COC(=O)C(=C)CO)C1CCC(c2ccc(-c3ccc(C4CCC(CCC)CC4)cc3F)c(F)c2F)CC1] |
| 1ϵ-12-24 | 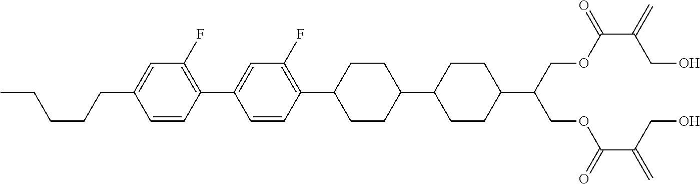 [SMILES: C=C(CO)C(=O)OCC(COC(=O)C(=C)CO)C1CCC(C2CCC(c3ccc(-c4ccc(CCCCC)cc4F)cc3F)CC2)CC1] |
| 1ϵ-12-25 | 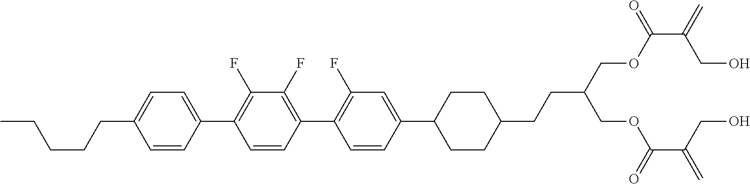 [SMILES: C=C(CO)C(=O)OCC(CCC1CCC(c2ccc(-c3ccc(-c4ccc(CCCCC)cc4)c(F)c3F)c(F)c2)CC1)COC(=O)C(=C)CO] |
| 1ϵ-12-26 | 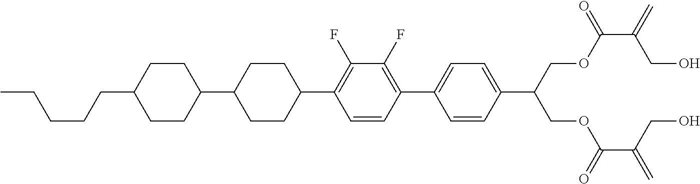 [SMILES: C=C(CO)C(=O)OCC(COC(=O)C(=C)CO)c1ccc(-c2ccc(C3CCC(C4CCC(CCCCC)CC4)CC3)c(F)c2F)cc1] |
| 1ϵ-12-27 | 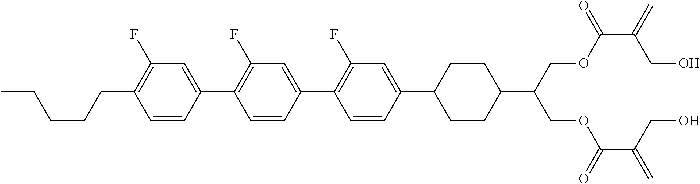 [SMILES: C=C(CO)C(=O)OCC(COC(=O)C(=C)CO)C1CCC(c2ccc(-c3ccc(-c4ccc(CCCCC)c(F)c4)c(F)c3)c(F)c2)CC1] |
| 1ϵ-12-28 | 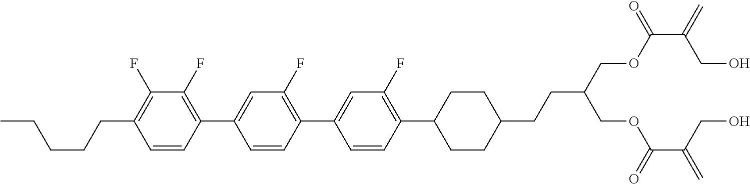 [SMILES: C=C(CO)C(=O)OCC(CCC1CCC(c2ccc(-c3ccc(-c4ccc(CCCCC)c(F)c4F)cc3F)cc2F)CC1)COC(=O)C(=C)CO] |
| 1ϵ-12-29 | 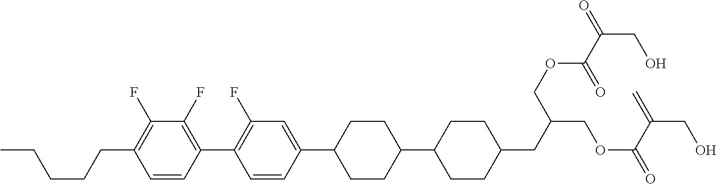 [SMILES: C=C(CO)C(=O)OCC(COC(=O)C(=O)CO)CC1CCC(C2CCC(c3ccc(-c4ccc(CCCCC)c(F)c4F)c(F)c3)CC2)CC1] |
| 1ϵ-12-30 | 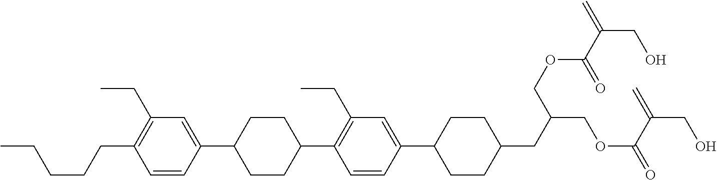 [SMILES: C=C(CO)C(=O)OCC(COC(=O)C(=C)CO)CC1CCC(c2ccc(C3CCC(c4ccc(CCCCC)c(CC)c4)CC3)c(CC)c2)CC1] |
| 1ϵ-12-31 | 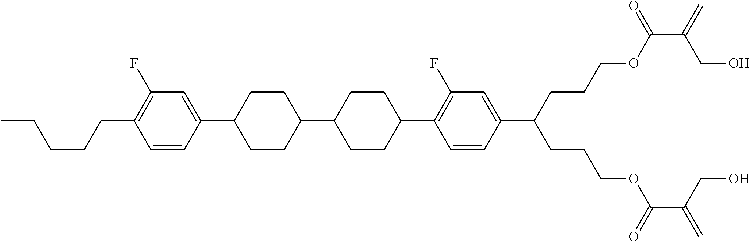 [SMILES: C=C(CO)C(=O)OCCCC(CCCOC(=O)C(=C)CO)c1ccc(C2CCC(C3CCC(c4ccc(CCCCC)c(F)c4)CC3)CC2)c(F)c1] |
| 1ϵ-12-32 | 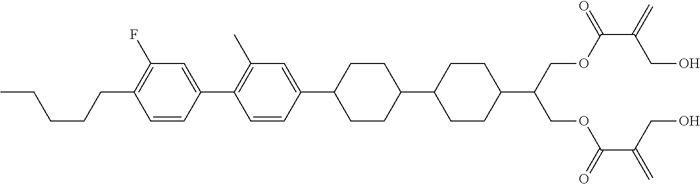 [SMILES: C=C(CO)C(=O)OCC(COC(=O)C(=C)CO)C1CCC(C2CCC(c3ccc(-c4ccc(CCCCC)c(F)c4)c(C)c3)CC2)CC1] |
| 1ϵ-12-33 | 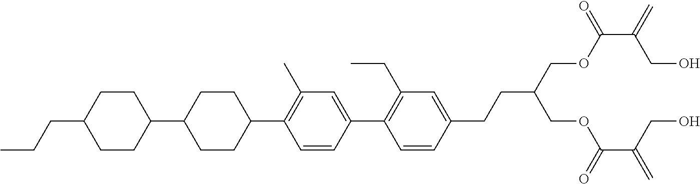 [SMILES: C=C(CO)C(=O)OCC(CCc1ccc(-c2ccc(C3CCC(C4CCC(CCC)CC4)CC3)c(C)c2)c(CC)c1)COC(=O)C(=C)CO] |
| 1ϵ-12-34 | 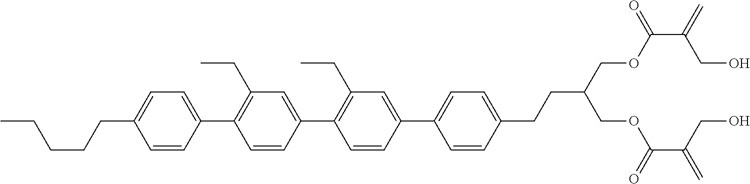 [SMILES: C=C(CO)C(=O)OCC(CCc1ccc(-c2ccc(-c3ccc(-c4ccc(CCCCC)cc4)c(CC)c3)c(CC)c2)cc1)COC(=O)C(=C)CO] |
| 1ϵ-12-35 | 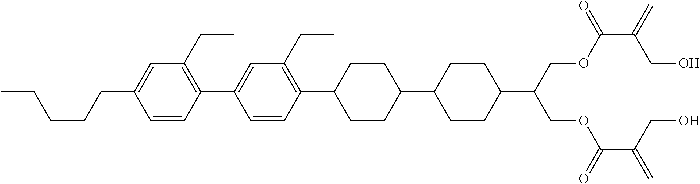 [SMILES: C=C(CO)C(=O)OCC(COC(=O)C(=C)CO)C1CCC(C2CCC(c3ccc(-c4ccc(CCCCC)cc4CC)cc3CC)CC2)CC1] |
| 1ϵ-12-36 | 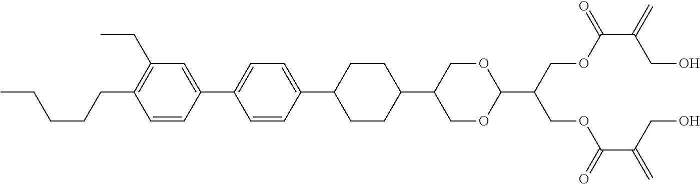 [SMILES: C=C(CO)C(=O)OCC(COC(=O)C(=C)CO)C1OCC(C2CCC(c3ccc(-c4ccc(CCCCC)c(CC)c4)cc3)CC2)CO1] |
| 1ϵ-12-37 | 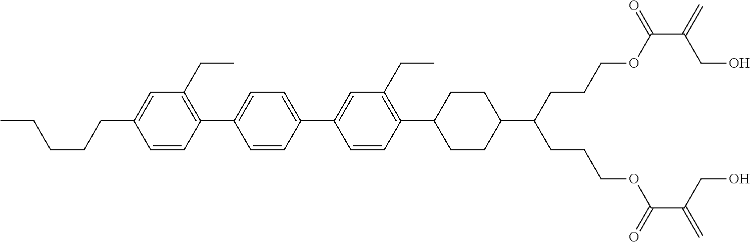 [SMILES: C=C(CO)C(=O)OCCCC(CCCOC(=O)C(=C)CO)C1CCC(c2ccc(-c3ccc(-c4ccc(CCCCC)cc4CC)cc3)cc2CC)CC1] |
| 1ϵ-12-38 | 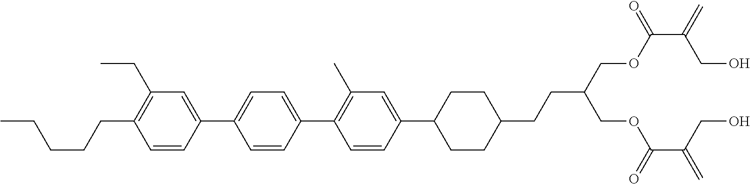 [SMILES: C=C(CO)C(=O)OCC(CCC1CCC(c2ccc(-c3ccc(-c4ccc(CCCCC)c(CC)c4)cc3)c(C)c2)CC1)COC(=O)C(=C)CO] |
| 1ϵ-12-39 | 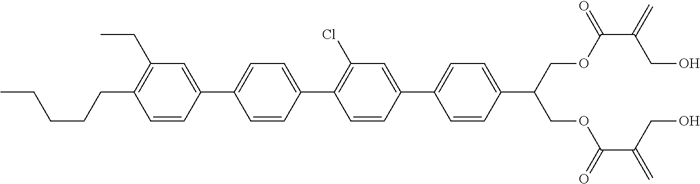 [SMILES: C=C(CO)C(=O)OCC(COC(=O)C(=C)CO)c1ccc(-c2ccc(-c3ccc(-c4ccc(CCCCC)c(CC)c4)cc3)c(Cl)c2)cc1] |
| 1ϵ-12-40 | 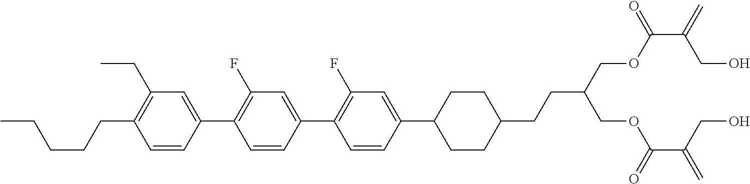 [SMILES: C=C(CO)C(=O)OCC(CCC1CCC(c2ccc(-c3ccc(-c4ccc(CCCCC)c(CC)c4)c(F)c3)c(F)c2)CC1)COC(=O)C(=C)CO] |
| 1ϵ-12-41 | 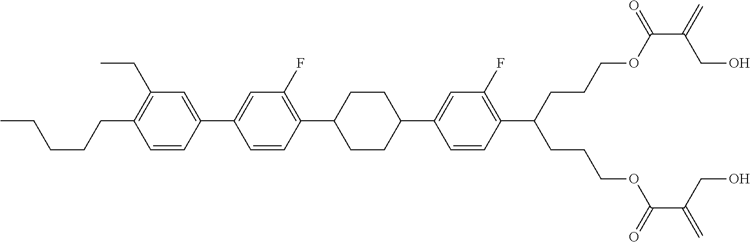 [SMILES: C=C(CO)C(=O)OCCCC(CCCOC(=O)C(=C)CO)c1ccc(C2CCC(c3ccc(-c4ccc(CCCCC)c(CC)c4)cc3F)CC2)cc1F] |
| 1ϵ-12-42 | 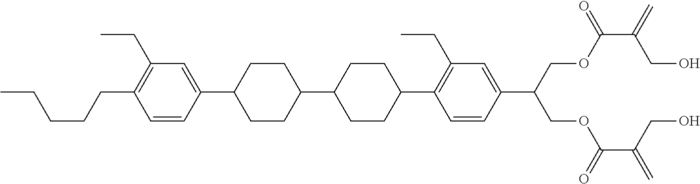 [SMILES: C=C(CO)C(=O)OCC(COC(=O)C(=C)CO)c1ccc(C2CCC(C3CCC(c4ccc(CCCCC)c(CC)c4)CC3)CC2)c(CC)c1] |
| 1ϵ-12-43 | 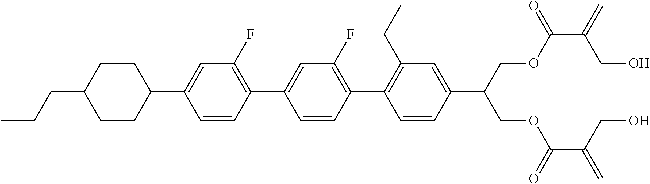 [SMILES: C=C(CO)C(=O)OCC(COC(=O)C(=C)CO)c1ccc(-c2ccc(-c3ccc(C4CCC(CCC)CC4)cc3F)cc2F)c(CC)c1] |
| 1ϵ-12-44 | 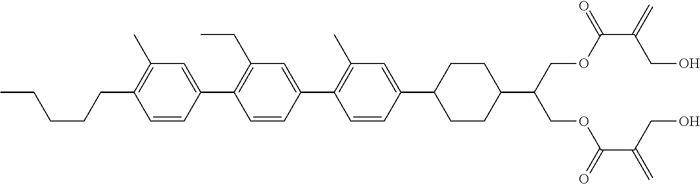 [SMILES: C=C(CO)C(=O)OCC(COC(=O)C(=C)CO)C1CCC(c2ccc(-c3ccc(-c4ccc(CCCCC)c(C)c4)c(CC)c3)c(C)c2)CC1] |
| 1ϵ-12-45 | 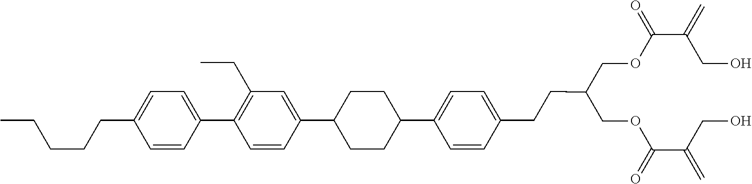 [SMILES: C=C(CO)C(=O)OCC(CCc1ccc(C2CCC(c3ccc(-c4ccc(CCCCC)cc4)c(CC)c3)CC2)cc1)COC(=O)C(=C)CO] |
| 1ϵ-12-46 | 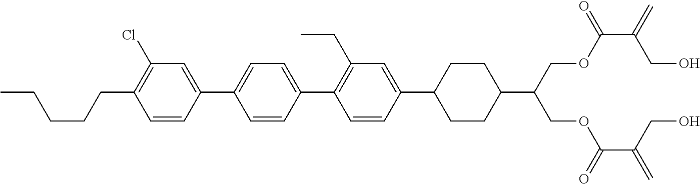 [SMILES: C=C(CO)C(=O)OCC(COC(=O)C(=C)CO)C1CCC(c2ccc(-c3ccc(-c4ccc(CCCCC)c(Cl)c4)cc3)c(CC)c2)CC1] |
| 1ϵ-12-47 | 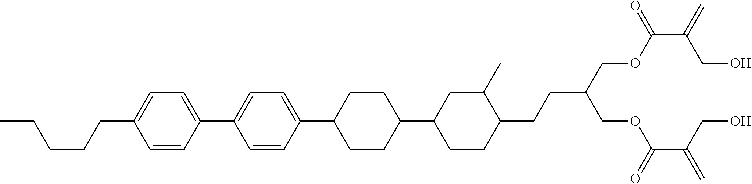 [SMILES: C=C(CO)C(=O)OCC(CCC1CCC(C2CCC(c3ccc(-c4ccc(CCCCC)cc4)cc3)CC2)CC1C)COC(=O)C(=C)CO] |
| 1ϵ-12-48 | 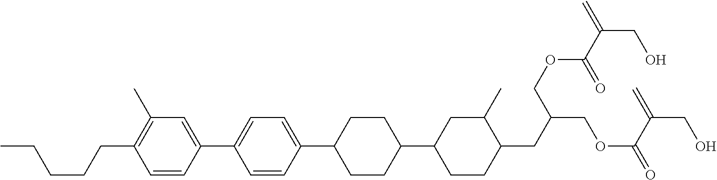 [SMILES: C=C(CO)C(=O)OCC(COC(=O)C(=C)CO)CC1CCC(C2CCC(c3ccc(-c4ccc(CCCCC)c(C)c4)cc3)CC2)CC1C] |
| 1ϵ-12-49 | 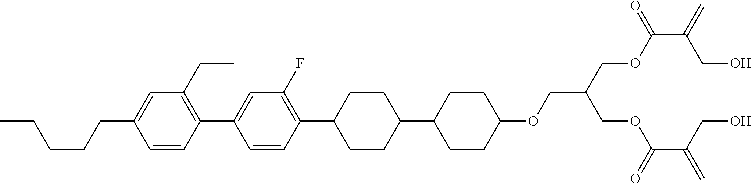 [SMILES: C=C(CO)C(=O)OCC(COC(=O)C(=C)CO)COC1CCC(C2CCC(c3ccc(-c4ccc(CCCCC)cc4CC)cc3F)CC2)CC1] |
| 1ϵ-12-50 | 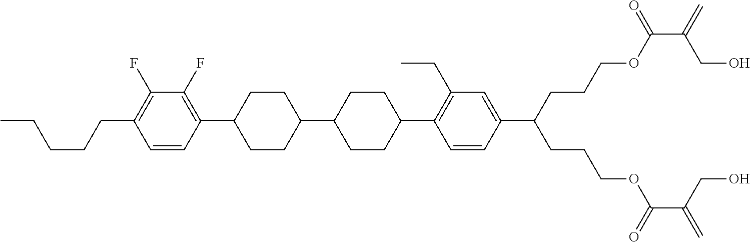 [SMILES: C=C(CO)C(=O)OCCCC(CCCOC(=O)C(=C)CO)c1ccc(C2CCC(C3CCC(c4ccc(CCCCC)c(F)c4F)CC3)CC2)c(CC)c1] |
| 1ϵ-12-51 | 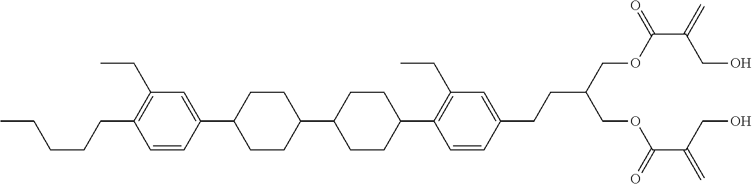 [SMILES: C=C(CO)C(=O)OCC(CCc1ccc(C2CCC(C3CCC(c4ccc(CCCCC)c(CC)c4)CC3)CC2)c(CC)c1)COC(=O)C(=C)CO] |
| 1ϵ-12-52 | 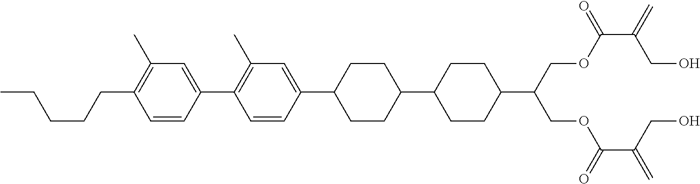 [SMILES: C=C(CO)C(=O)OCC(COC(=O)C(=C)CO)C1CCC(C2CCC(c3ccc(-c4ccc(CCCCC)c(C)c4)c(C)c3)CC2)CC1] |
| 1ϵ-12-53 | 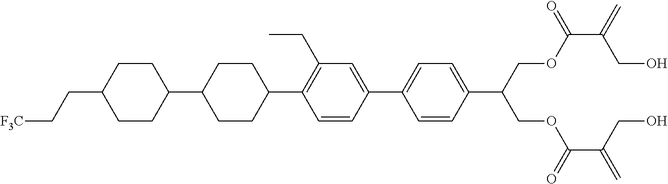 [SMILES: C=C(CO)C(=O)OCC(COC(=O)C(=C)CO)c1ccc(-c2ccc(C3CCC(C4CCC(CCC(F)(F)F)CC4)CC3)c(CC)c2)cc1] |
| 1ϵ-12-54 | 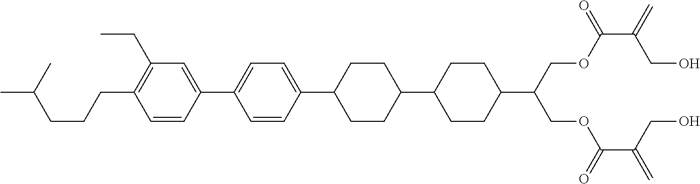 [SMILES: C=C(CO)C(=O)OCC(COC(=O)C(=C)CO)C1CCC(C2CCC(c3ccc(-c4ccc(CCCC(C)C)c(CC)c4)cc3)CC2)CC1] |
| 1ϵ-12-55 | 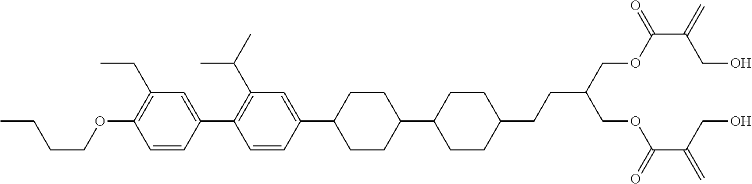 [SMILES: C=C(CO)C(=O)OCC(CCC1CCC(C2CCC(c3ccc(-c4ccc(OCCCC)c(CC)c4)c(C(C)C)c3)CC2)CC1)COC(=O)C(=C)CO] |
| 1ϵ-12-56 | 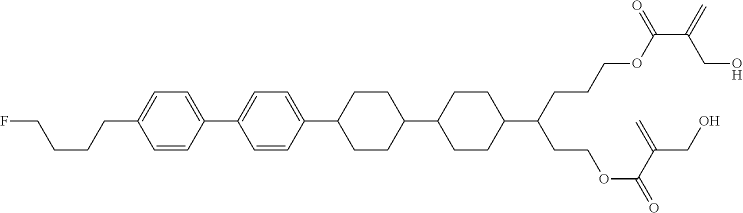 [SMILES: C=C(CO)C(=O)OCCCC(CCOC(=O)C(=C)CO)C1CCC(C2CCC(c3ccc(-c4ccc(CCCCF)cc4)cc3)CC2)CC1] |
| 1ϵ-12-57 | 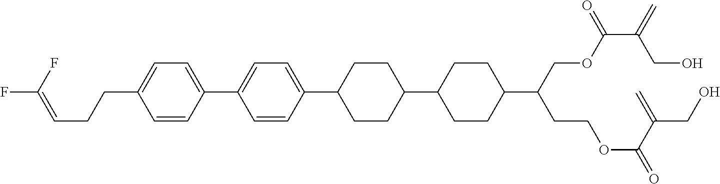 [SMILES: C=C(CO)C(=O)OCCC(COC(=O)C(=C)CO)C1CCC(C2CCC(c3ccc(-c4ccc(CCC=C(F)F)cc4)cc3)CC2)CC1] |
| 1ϵ-12-58 | 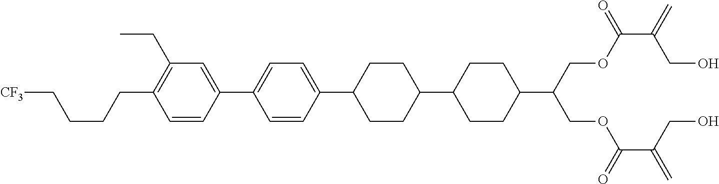 [SMILES: C=C(CO)C(=O)OCC(COC(=O)C(=C)CO)C1CCC(C2CCC(c3ccc(-c4ccc(CCCCC(F)(F)F)c(CC)c4)cc3)CC2)CC1] |
| 1ϵ-12-59 | 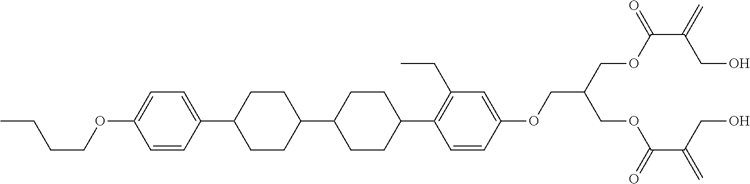 [SMILES: C=C(CO)C(=O)OCC(COC(=O)C(=C)CO)COc1ccc(C2CCC(C3CCC(c4ccc(OCCCC)cc4)CC3)CC2)c(CC)c1] |
| 1ϵ-12-60 | 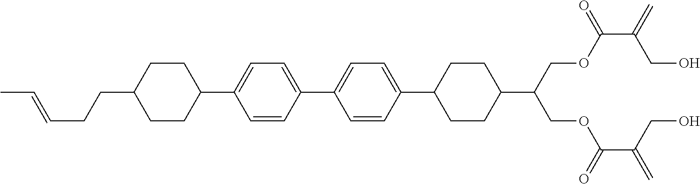 [SMILES: C=C(CO)C(=O)OCC(COC(=O)C(=C)CO)C1CCC(c2ccc(-c3ccc(C4CCC(CC/C=C/C)CC4)cc3)cc2)CC1] |
| 1ϵ-12-61 | 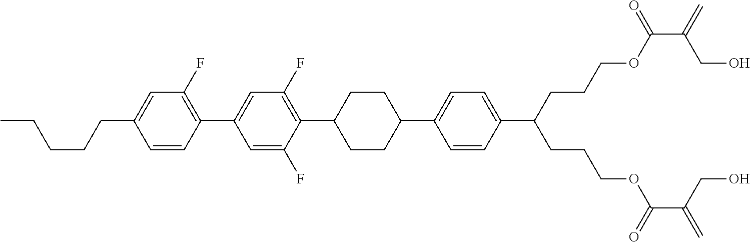 [SMILES: C=C(CO)C(=O)OCCCC(CCCOC(=O)C(=C)CO)c1ccc(C2CCC(c3c(F)cc(-c4ccc(CCCCC)cc4F)cc3F)CC2)cc1] |
| 1ϵ-12-62 | 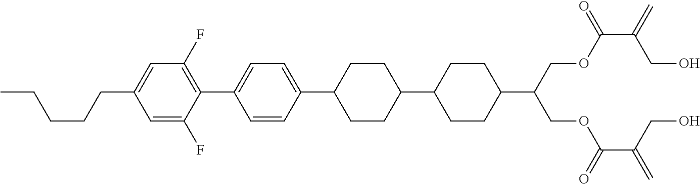 [SMILES: C=C(CO)C(=O)OCC(COC(=O)C(=C)CO)C1CCC(C2CCC(c3ccc(-c4c(F)cc(CCCCC)cc4F)cc3)CC2)CC1] |
| 1ϵ-12-63 | 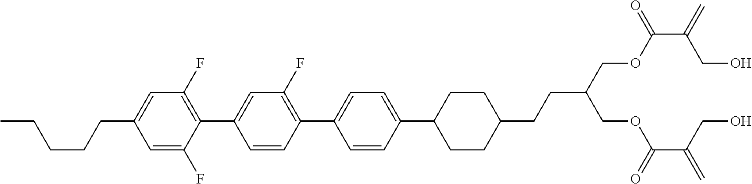 [SMILES: C=C(CO)C(=O)OCC(CCC1CCC(c2ccc(-c3ccc(-c4c(F)cc(CCCCC)cc4F)cc3F)cc2)CC1)COC(=O)C(=C)CO] |
| 1ϵ-12-64 | 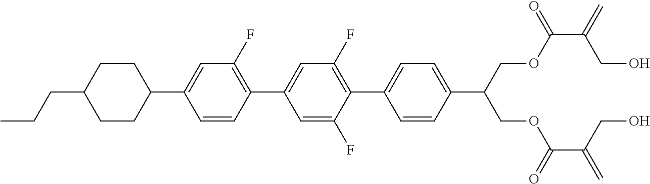 [SMILES: C=C(CO)C(=O)OCC(COC(=O)C(=C)CO)c1ccc(-c2c(F)cc(-c3ccc(C4CCC(CCC)CC4)cc3F)cc2F)cc1] |
| 1ϵ-12-65 | 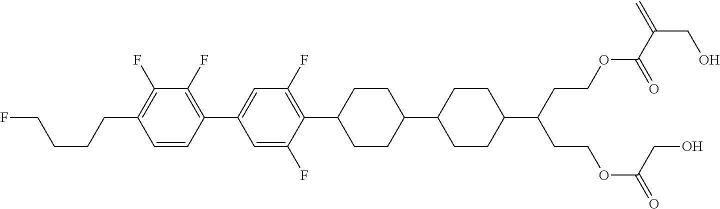 [SMILES: C=C(CO)C(=O)OCCC(CCOC(=O)CO)C1CCC(C2CCC(c3c(F)cc(-c4ccc(CCCCF)c(F)c4F)cc3F)CC2)CC1] |
| 1ϵ-12-66 | 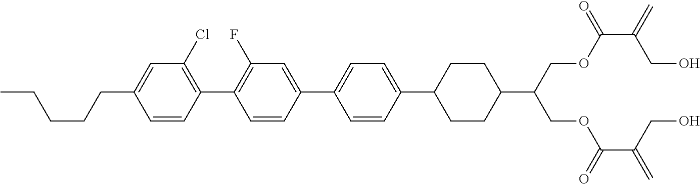 [SMILES: C=C(CO)C(=O)OCC(COC(=O)C(=C)CO)C1CCC(c2ccc(-c3ccc(-c4ccc(CCCCC)cc4Cl)c(F)c3)cc2)CC1] |
| 1ϵ-12-67 | 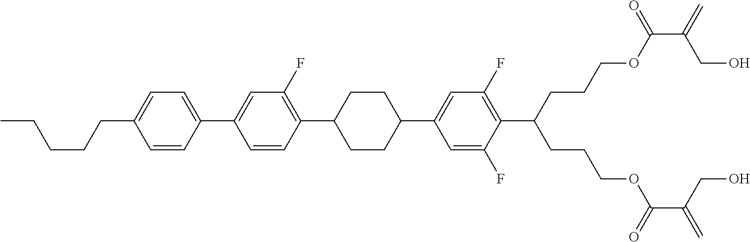 [SMILES: C=C(CO)C(=O)OCCCC(CCCOC(=O)C(=C)CO)c1c(F)cc(C2CCC(c3ccc(-c4ccc(CCCCC)cc4)cc3F)CC2)cc1F] |
| 1ϵ-12-68 | 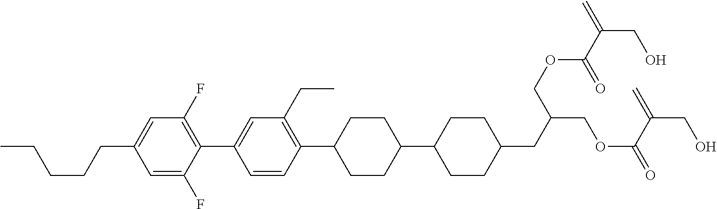 [SMILES: C=C(CO)C(=O)OCC(COC(=O)C(=C)CO)CC1CCC(C2CCC(c3ccc(-c4c(F)cc(CCCCC)cc4F)cc3CC)CC2)CC1] |
| 1ϵ-12-69 | 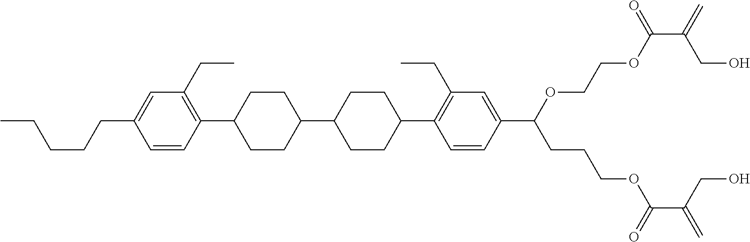 [SMILES: C=C(CO)C(=O)OCCCC(OCCOC(=O)C(=C)CO)c1ccc(C2CCC(C3CCC(c4ccc(CCCCC)cc4CC)CC3)CC2)c(CC)c1] |
| 1ϵ-12-70 | 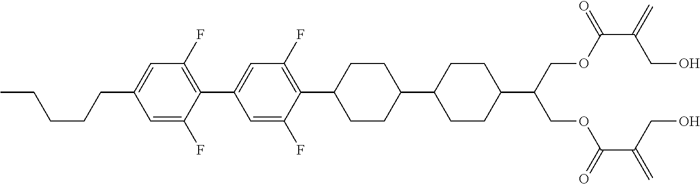 [SMILES: C=C(CO)C(=O)OCC(COC(=O)C(=C)CO)C1CCC(C2CCC(c3c(F)cc(-c4c(F)cc(CCCCC)cc4F)cc3F)CC2)CC1] |
| 1ϵ-12-71 | 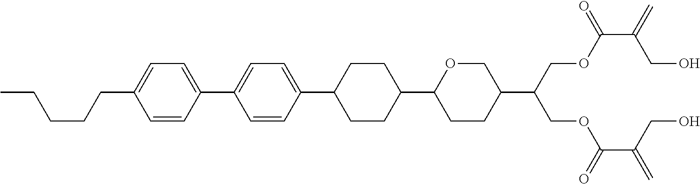 [SMILES: C=C(CO)C(=O)OCC(COC(=O)C(=C)CO)C1CCC(C2CCC(c3ccc(-c4ccc(CCCCC)cc4)cc3)CC2)OC1] |
| 1ϵ-12-72 | 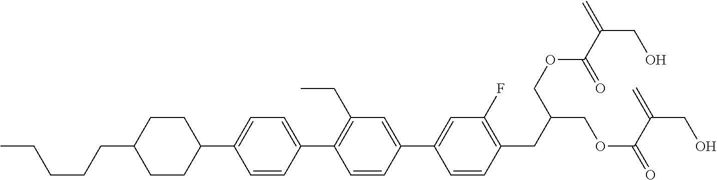 [SMILES: C=C(CO)C(=O)OCC(COC(=O)C(=C)CO)Cc1ccc(-c2ccc(-c3ccc(C4CCC(CCCCC)CC4)cc3)c(CC)c2)cc1F] |
| 1ϵ-12-73 | 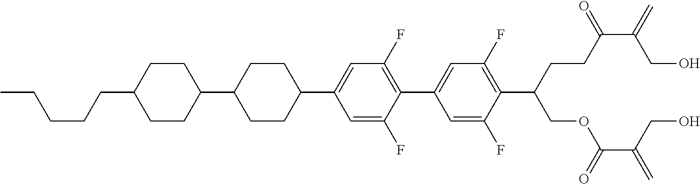 [SMILES: C=C(CO)C(=O)CCC(COC(=O)C(=C)CO)c1c(F)cc(-c2c(F)cc(C3CCC(C4CCC(CCCCC)CC4)CC3)cc2F)cc1F] |
| 1ϵ-12-74 | 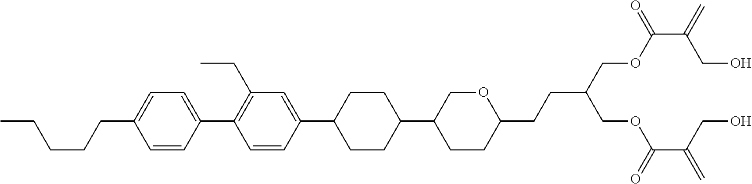 [SMILES: C=C(CO)C(=O)OCC(CCC1CCC(C2CCC(c3ccc(-c4ccc(CCCCC)cc4)c(CC)c3)CC2)CO1)COC(=O)C(=C)CO] |
| 1ϵ-12-75 | 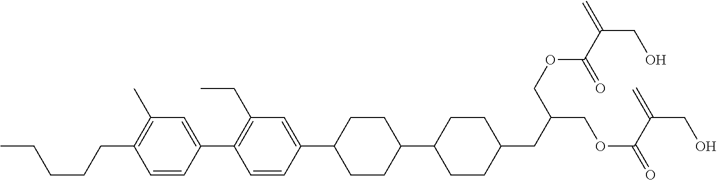 [SMILES: C=C(CO)C(=O)OCC(COC(=O)C(=C)CO)CC1CCC(C2CCC(c3ccc(-c4ccc(CCCCC)c(C)c4)c(CC)c3)CC2)CC1] |
| 1ϵ-12-76 | 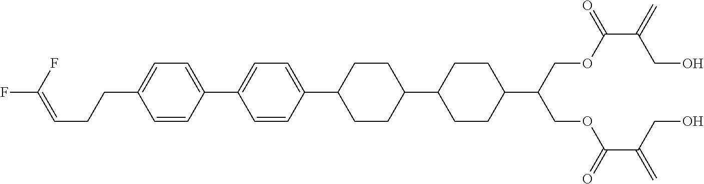 [SMILES: C=C(CO)C(=O)OCC(COC(=O)C(=C)CO)C1CCC(C2CCC(c3ccc(-c4ccc(CCC=C(F)F)cc4)cc3)CC2)CC1] |
| 1ϵ-12-77 | 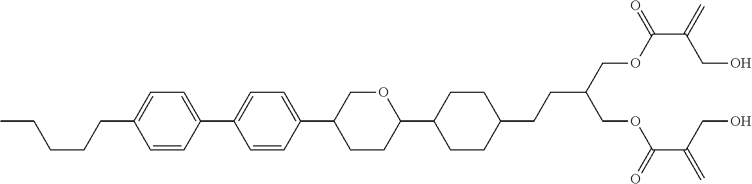 [SMILES: C=C(CO)C(=O)OCC(CCC1CCC(C2CCC(c3ccc(-c4ccc(CCCCC)cc4)cc3)CO2)CC1)COC(=O)C(=C)CO] |
| 1ϵ-12-78 | 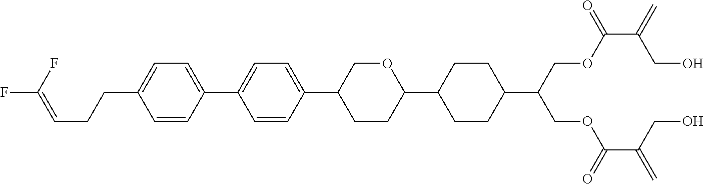 [SMILES: C=C(CO)C(=O)OCC(COC(=O)C(=C)CO)C1CCC(C2CCC(c3ccc(-c4ccc(CCC=C(F)F)cc4)cc3)CO2)CC1] |
| 1ϵ-12-79 | 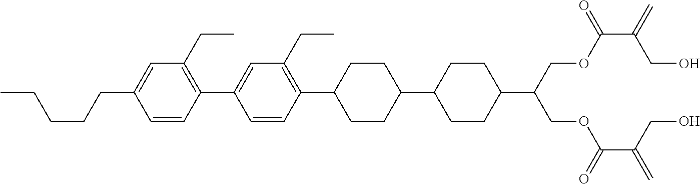 [SMILES: C=C(CO)C(=O)OCC(COC(=O)C(=C)CO)C1CCC(C2CCC(c3ccc(-c4ccc(CCCCC)cc4CC)cc3CC)CC2)CC1] |
| 1ϵ-12-80 | 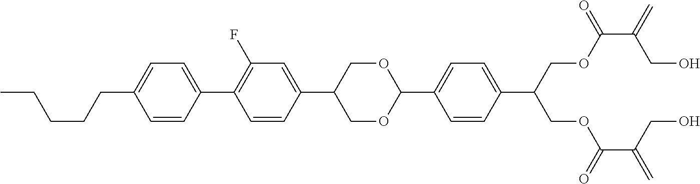 [SMILES: C=C(CO)C(=O)OCC(COC(=O)C(=C)CO)c1ccc(C2OCC(c3ccc(-c4ccc(CCCCC)cc4)c(F)c3)CO2)cc1] |
| 1ϵ-12-81 | 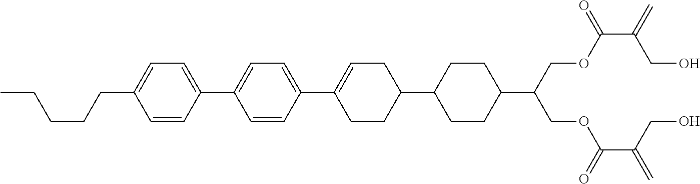 [SMILES: C=C(CO)C(=O)OCC(COC(=O)C(=C)CO)C1CCC(C2CC=C(c3ccc(-c4ccc(CCCCC)cc4)cc3)CC2)CC1] |
| 1ϵ-12-82 | 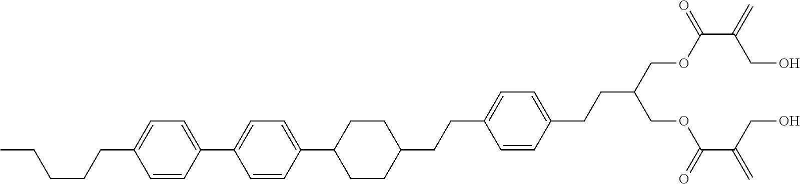 [SMILES: C=C(CO)C(=O)OCC(CCc1ccc(CCC2CCC(c3ccc(-c4ccc(CCCCC)cc4)cc3)CC2)cc1)COC(=O)C(=C)CO] |
| 1ϵ-12-83 | 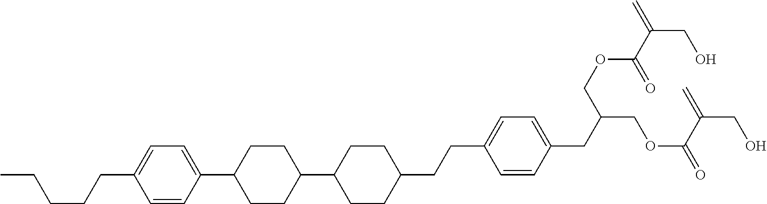 [SMILES: C=C(CO)C(=O)OCC(COC(=O)C(=C)CO)Cc1ccc(CCC2CCC(C3CCC(c4ccc(CCCCC)cc4)CC3)CC2)cc1] |
| 1ϵ-12-84 | 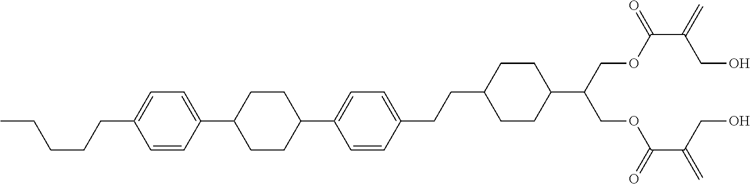 [SMILES: C=C(CO)C(=O)OCC(COC(=O)C(=C)CO)C1CCC(CCc2ccc(C3CCC(c4ccc(CCCCC)cc4)CC3)cc2)CC1] |
| 1ϵ-12-85 | 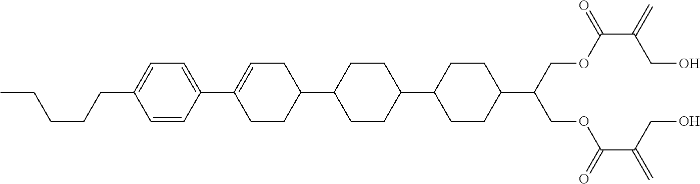 [SMILES: C=C(CO)C(=O)OCC(COC(=O)C(=C)CO)C1CCC(C2CCC(C3CC=C(c4ccc(CCCCC)cc4)CC3)CC2)CC1] |
| 1ϵ-12-86 | 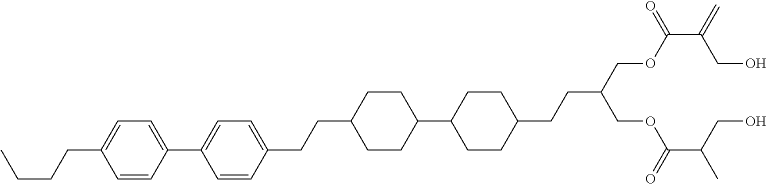 [SMILES: C=C(CO)C(=O)OCC(CCC1CCC(C2CCC(CCc3ccc(-c4ccc(CCCC)cc4)cc3)CC2)CC1)COC(=O)C(C)CO] |
| 1ϵ-12-87 | 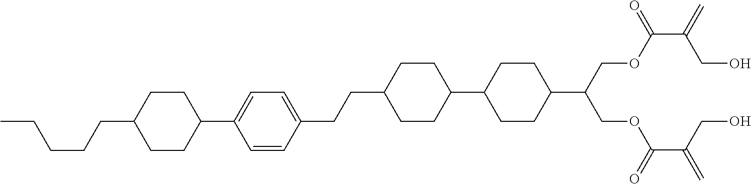 [SMILES: C=C(CO)C(=O)OCC(COC(=O)C(=C)CO)C1CCC(C2CCC(CCc3ccc(C4CCC(CCCCC)CC4)cc3)CC2)CC1] |
| 1ϵ-12-88 | 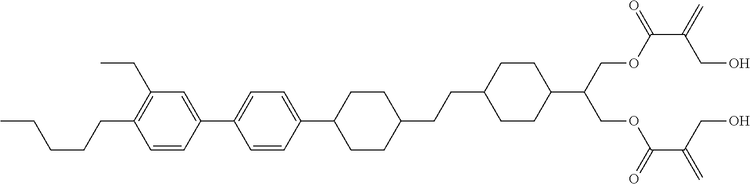 [SMILES: C=C(CO)C(=O)OCC(COC(=O)C(=C)CO)C1CCC(CCC2CCC(c3ccc(-c4ccc(CCCCC)c(CC)c4)cc3)CC2)CC1] |
| 1ϵ-12-89 | 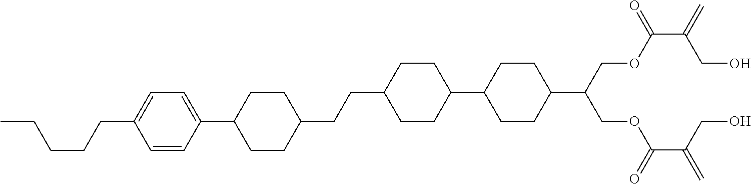 [SMILES: C=C(CO)C(=O)OCC(COC(=O)C(=C)CO)C1CCC(C2CCC(CCC3CCC(c4ccc(CCCCC)cc4)CC3)CC2)CC1] |
| 1ϵ-12-90 | 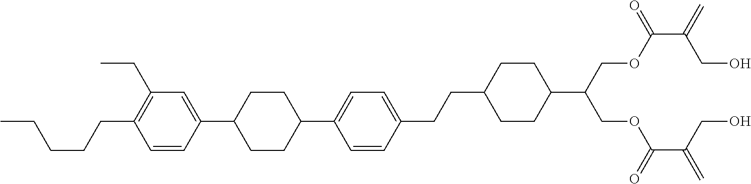 [SMILES: C=C(CO)C(=O)OCC(COC(=O)C(=C)CO)C1CCC(CCc2ccc(C3CCC(c4ccc(CCCCC)c(CC)c4)CC3)cc2)CC1] |
| 1ϵ-12-91 | 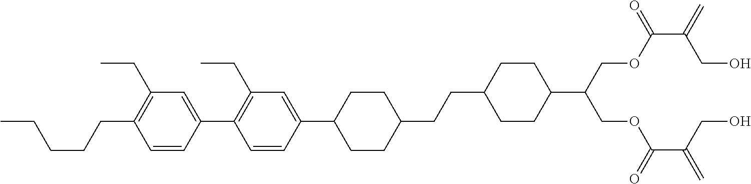 [SMILES: C=C(CO)C(=O)OCC(COC(=O)C(=C)CO)C1CCC(CCC2CCC(c3ccc(-c4ccc(CCCCC)c(CC)c4)c(CC)c3)CC2)CC1] |
| 1ϵ-12-92 | 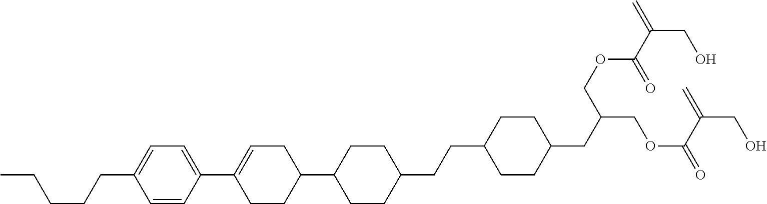 [SMILES: C=C(CO)C(=O)OCC(COC(=O)C(=C)CO)CC1CCC(CCC2CCC(C3CC=C(c4ccc(CCCCC)cc4)CC3)CC2)CC1] |
| 1ϵ-12-93 | 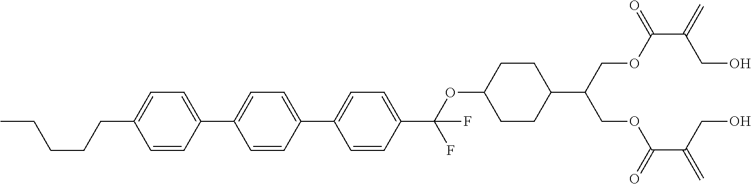 [SMILES: C=C(CO)C(=O)OCC(COC(=O)C(=C)CO)C1CCC(OC(F)(F)c2ccc(-c3ccc(-c4ccc(CCCCC)cc4)cc3)cc2)CC1] |
| 1ϵ-12-94 | 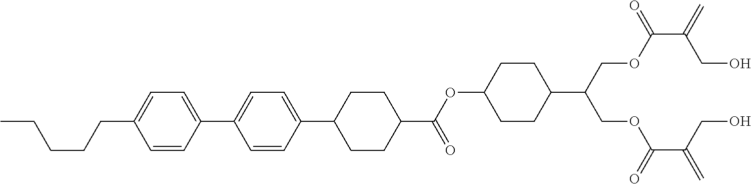 [SMILES: C=C(CO)C(=O)OCC(COC(=O)C(=C)CO)C1CCC(OC(=O)C2CCC(c3ccc(-c4ccc(CCCCC)cc4)cc3)CC2)CC1] |
| 1ϵ-12-95 | 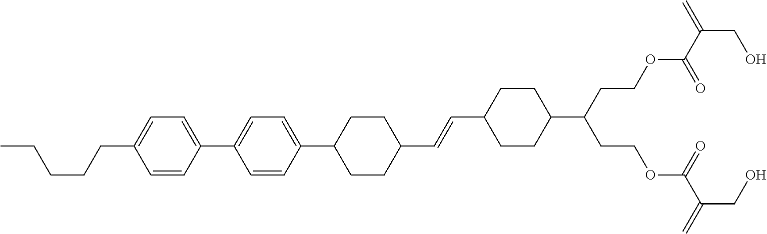 [SMILES: C=C(CO)C(=O)OCCC(CCOC(=O)C(=C)CO)C1CCC(/C=C/C2CCC(c3ccc(-c4ccc(CCCCC)cc4)cc3)CC2)CC1] |
| 1ϵ-12-96 | 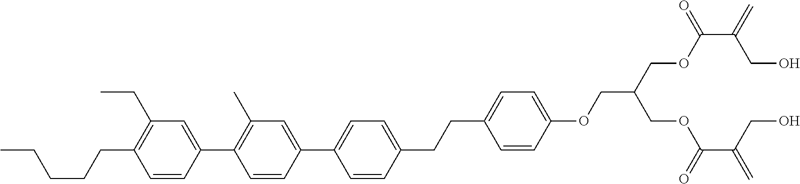 [SMILES: C=C(CO)C(=O)OCC(COC(=O)C(=C)CO)COc1ccc(CCc2ccc(-c3ccc(-c4ccc(CCCCC)c(CC)c4)c(C)c3)cc2)cc1] |
| 1ϵ-12-97 | 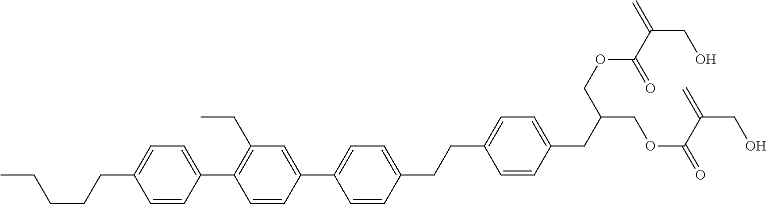 [SMILES: C=C(CO)C(=O)OCC(COC(=O)C(=C)CO)Cc1ccc(CCc2ccc(-c3ccc(-c4ccc(CCCCC)cc4)c(CC)c3)cc2)cc1] |
| 1ϵ-12-98 | 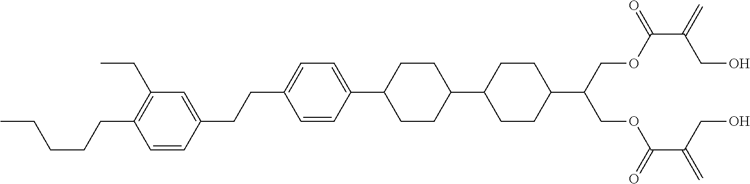 [SMILES: C=C(CO)C(=O)OCC(COC(=O)C(=C)CO)C1CCC(C2CCC(c3ccc(CCc4ccc(CCCCC)c(CC)c4)cc3)CC2)CC1] |
| 1ϵ-12-99 | 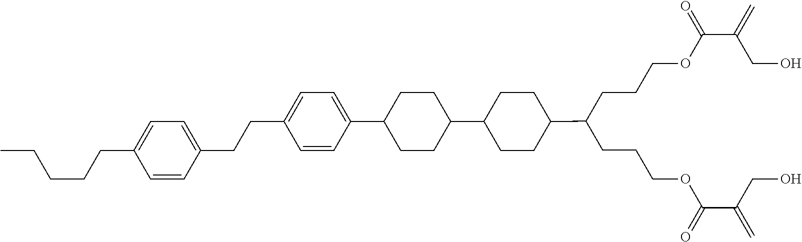 [SMILES: C=C(CO)C(=O)OCCCC(CCCOC(=O)C(=C)CO)C1CCC(C2CCC(c3ccc(CCc4ccc(CCCCC)cc4)cc3)CC2)CC1] |
| 1ϵ-12-100 | 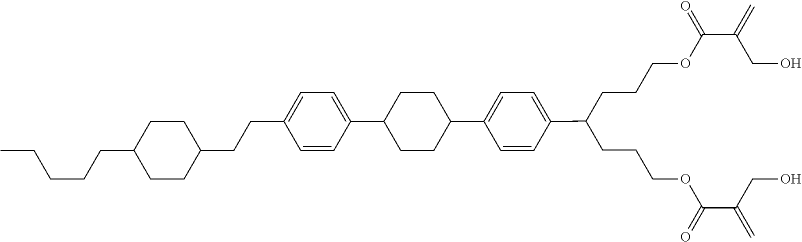 [SMILES: C=C(CO)C(=O)OCCCC(CCCOC(=O)C(=C)CO)c1ccc(C2CCC(c3ccc(CCC4CCC(CCCCC)CC4)cc3)CC2)cc1] |

### INDUSTRIAL APPLICABILITY

Compound (1) has high chemical stability, high capability of aligning liquid crystal molecules, high solubility in a liquid crystal composition, and a large voltage holding ratio when compound (1) is used in a liquid crystal display device. A liquid crystal composition containing compound (1) satisfies at least one of characteristics such as high maximum temperature, low minimum temperature, small viscosity, suitable optical anisotropy, large positive or negative dielectric anisotropy, large specific resistance, high stability to ultraviolet light, high stability to heat and a large elastic constant. A liquid crystal display device including the composition according to the application has characteristics such as a wide temperature range in which the device can be used, a short response time, a large voltage holding ratio, low threshold voltage, a large contrast ratio and a long service life, and therefore can be used in a liquid crystal projector, a liquid crystal television and so forth. Further, compound (1) is a polymerizable compound having a mesogen moiety formed of at least one ring, and a polar group, and can form an alignment control layer by polymerization, and therefore in the liquid crystal display device according to the application, formation of an alignment film such as a polyimide alignment film is not required separately.

Publications cited herein, all of the references, including patent applications and patents, individually and specifically indicated to each document, and incorporated by reference, and forth in its entirety herein in the same extent, incorporated by reference herein.

Use of the noun and the similar directive used in connection with the description (particularly with reference to the following claims) in the present invention, or particularly pointed out herein, unless otherwise indicated herein or otherwise clearly contradicted by context, is to be construed to cover both the singular form and the plural form. The terms “comprising,” “having,” “including” and “containing,” unless otherwise noted, be construed as open-ended terms (namely, meaning “including, but not limited to”). Recitations of numerical ranges herein, unless otherwise indicated herein, is intended merely to serve as shorthand for referring individually each value falling within its scope and which, each value, as if it were individually recited herein, are incorporated herein. All of the methods described herein, or particularly pointed out herein, unless otherwise indicated herein or otherwise clearly contradicted by context, can be performed in any suitable order. The use of any and all examples, or exemplary language (“such as”) provided herein, is intended merely to better illuminate the invention and does not pose a limitation on the scope of the invention unless otherwise claimed. No language herein should be construed as indicating any non-claimed element as essential to the practice of the invention.

Preferred embodiments of the invention are described herein, including the best modes known to the present inventors for carrying out the invention. Variations of the preferred embodiments may become apparent to those having ordinary skill in the art upon reading the foregoing description. The present inventors expect skilled artisans to employ such variations as appropriate, and the present inventors intend for the invention to be practiced otherwise than as specifically described herein. Accordingly, the invention includes all modifications and equivalents of the subject matters recited in the claims appended hereto as permitted by applicable laws. Further, particularly pointed out herein, unless otherwise indicated or otherwise clearly contradicted by context, any combination of the above-described elements in all possible variations thereof is encompassed by the invention.

### REFERENCE SIGNS LIST

1 Color filter substrate
2 Array substrate
3 Liquid crystal composition
4 Liquid crystal compound
5 Polymerizable polar compound, alignable monomer, compound (1)
6 Polymerizable compound, reactive monomer, compound (16)
7 Alignment film
8 Polymerizable compound
11, 12 Device
21 Conventional device

1. A liquid crystal display device, comprising:
a first substrate;
a plurality of pixel electrodes formed on the first substrate;
a second substrate;
a counter electrode formed on the second substrate and facing the pixel electrode;
a liquid crystal layer including a liquid crystal composition between the pixel electrode and the counter electrode; and
an alignment control layer formed of a polymer containing an alignable monomer that is one component of the liquid crystal composition, in which the alignment control layers are each formed on a side of the first substrate and on a side of the second substrate; wherein
the alignable monomer is a polymerizable polar compound having a mesogen moiety formed of at least one ring, and a polar group.

2. The liquid crystal display device according to claim 1, wherein
the mesogen moiety includes a cyclohexane ring.

3. The liquid crystal display device according to claim 1, wherein the alignable monomer is a compound represented by formula (1α): 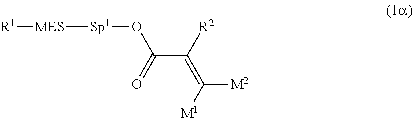
wherein, in formula (1α),
R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;
MES is a mesogen group having at least one ring;
Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;
M¹ and M² are independently hydrogen, halogen, alkyl having 1 to 5 carbons, or alkyl having 1 to 5 carbons in which at least one hydrogen is replaced by halogen; and
R² is a group represented by formula (1αa), (1αb) or (1αc): 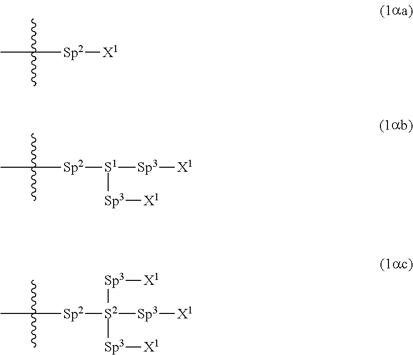
wherein, in formulas (1αa), (1αb) and (1αc),
Sp² and Sp³ are independently a single bond or alkyl ene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;
S¹ is >CH— or >N—;
S² is >C< or >Si<; and
X¹ is a group represented by —OH, —NH₂, —OR³, —N(R³)₂, formula (x1), —COOH, —SH, —B(OH)₂ or —Si(R³)₃, in which R³ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen, and w in formula (x1) is 1, 2, 3 or 4

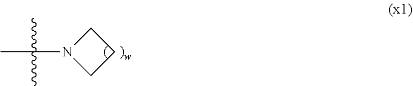

4. The liquid crystal display device according to claim 1, wherein the alignable monomer is a compound represented by formula (1β): 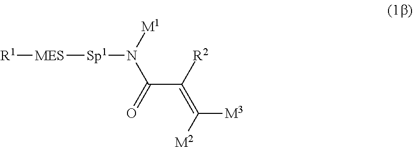
wherein, in formula (1β),
R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;
MES is a mesogen group having at least one ring;
Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen; and
R², M¹, M² and M³ are independently hydrogen, halogen or alkyl having 1 to 10 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen.

5. The liquid crystal display device according to claim 1, wherein the alignable monomer is a compound represented by formula (1γ): 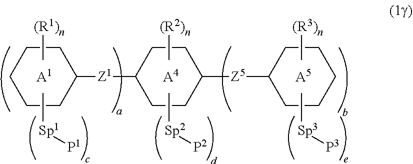
wherein, in formula (1γ),
R¹, R² and R³ are independently hydrogen or alkyl having 1 to 15 carbons, and in the alkyl, at least one —CH₂— may be replaced by —O—, —S— or —NH—, and at least one —(CH₂)₂— may be replaced by —CH═CH—, and in the groups, at least one hydrogen may be replaced by halogen;
n is independently 0, 1 or 2;
ring A⁴ is cyclohexylene, cyclohexenylene, phenylene, naphthalene, decahydronaphthalene, tetrahydronaphthalene, tetrahydropyran, 1,3-dioxane, pyrimidine or pyridine, and ring A¹ and ring A⁵ are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and
in the rings, at least one hydrogen may be replaced by fluorine, chlorine, alkenyl having 2 to 12 carbons, alkoxy having 1 to 11 carbons or alkenyloxy having 2 to 11 carbons, and in the groups, at least one hydrogen may be replaced by fluorine or chlorine;
Z¹ and Z⁵ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine;
Sp¹, Sp² and Sp³ are independently a single bond or alkylene having 1 to 10 carbons, and in the alkylene, at least one —CH₂— may be replaced by —O—, —COO—, —OCO— or —OCOO—, and at least one —(CH₂)₂— may be replaced by —CH═CH— or —C≡C—, and in the groups, at least one hydrogen may be replaced by fluorine or chlorine;
a and b are independently 0, 1, 2, 3 or 4, and a sum of a and b is 1, 2, 3 or 4;
c, d and e are independently 0, 1, 2, 3 or 4;
a sum of c, d and e is 2, 3 or 4; and
P¹, P² and P³ are independently a polymerizable group represented by formula (P-1): 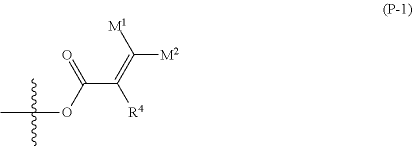
wherein, in formula (P-1),
M¹ and M² are independently hydrogen, halogen, alkyl having 1 to 5 carbons, or alkyl having 1 to 5 carbons in which at least one hydrogen is replaced by halogen; and
R⁴ is a group selected from groups represented by formulas (1γa), (1γb) and (1γc): 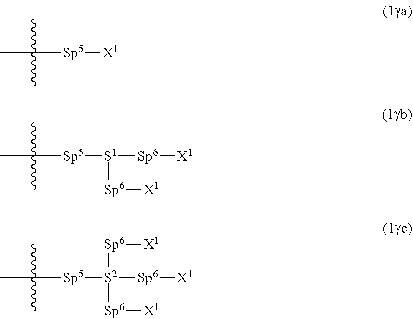
wherein, in formulas (1γa), (1γb) and (1γc),
Sp⁵ and Sp⁶ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;
S¹ is >CH— or >N—;
S² is >C< or >Si<; and
X¹ is independently a group represented by —OH, —NH₂, —OR⁵, —N(R⁵)₂, —COOH, —SH, —B(OH)₂ or —Si(R⁵)₃, in which R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen.

6. The liquid crystal display device according to claim 1, wherein the alignable monomer is a compound represented by formula (1δ-1): 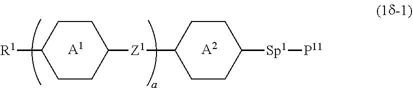
wherein, in formula (1δ-1),
R¹ is alkyl having 1 to 15 carbons, and in R¹, at least one —CH₂— may be replaced by —O— or —S—, at least one —CH₂CH₂— may be replaced by —CH═CH— or —C≡C—, and at least one hydrogen may be replaced by halogen;
ring A¹ and ring A² are independently 1,4-cyclohexylene, 1,4-cyclohexenylene, 1,4-phenylene, naphthalene-2,6-diyl, decahydronaphthalene-2,6-diyl, 1,2,3,4-tetrahydronaphthalene-2,6-diyl, tetrahydropyran-2,5-diyl, 1,3-dioxane-2,5-diyl, pyrimidine-2,5-diyl, pyridine-2,5-diyl, fluorene-2,7-diyl, phenanthrene-2,7-diyl, anthracene-2,6-diyl, perhydrocyclopenta[a]phenanthrene-3,17-diyl or 2,3,4,7,8,9,10,11,12,13,14,15,16,17-tetradecahydrocyclopenta[a]phenanthrene-3,17-diyl, and in the rings, at least one hydrogen may be replaced by fluorine, chlorine, alkyl having 1 to 12 carbons, alkenyl having 2 to 12 carbons, alkoxy having 1 to 11 carbons or alkenyloxy having 2 to 11 carbons, and in the groups, at least one hydrogen may be replaced by fluorine or chlorine;
a is 0, 1, 2, 3 or 4;
Z¹ is a single bond or alkylene having 1 to 6 carbons, and in Z¹ at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by fluorine or chlorine; and
Sp¹ is a single bond or alkylene having 1 to 10 carbons, and in Sp¹, at least one —CH₂— may be replaced by —O—, —CO—, —COO—, —OCO— or —OCOO—, at least one —CH₂CH₂— may be replaced by —CH—CH— or —C≡C—, and at least one hydrogen may be replaced by halogen, and in the groups, at least one hydrogen is replaced by a group selected from groups represented by formula (1δa): 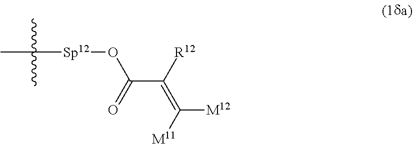
wherein, in formula (1δa),
Sp¹² is a single bond or alkylene having 1 to 10 carbons, and in Sp¹², at least one —CH₂— may be replaced by —O—, —CO—, —COO—, —OCO— or —OCOO—, at least one —CH₂CH₂— may be replaced by —CH═CH— or —C≡C—, and at least one hydrogen may be replaced by halogen;
M¹¹ and M¹² are independently hydrogen, halogen, alkyl having 1 to 5 carbons, or alkyl having 1 to 5 carbons in which at least one hydrogen is replaced by halogen;
R¹² is alkyl having 1 to 15 carbons, and in R¹², at least one —CH₂— may be replaced by —O— or —S—, at least one —CH₂CH₂— may be replaced by —CH═CH— or —C≡C—, and at least one hydrogen may be replaced by halogen; and
in formula (1δ-1),
P¹¹ is a group selected from groups represented by formulas (1δe) and (1δf): 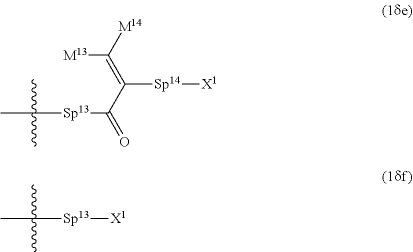
wherein, in formulas (1δe) and (1δf),
Sp¹³ is a single bond or alkylene having 1 to 10 carbons, and in Sp¹³, at least one —CH₂— may be replaced by —O—, —NH—, —CO—, —COO—, —OCO— or —OCOO—, and at least one —CH₂CH₂— may be replaced by —CH═CH— or —C≡C—, and in the groups, at least one hydrogen may be replaced by halogen;
Sp¹⁴ is a single bond or alkylene having 1 to 10 carbons, and in Sp¹⁴, at least one —CH₂— may be replaced by —O—, —NH—, —CO—, —COO—, —OCO— or —OCOO—, at least one —CH₂CH₂— may be replaced by —CH═CH— or —C≡C—, and at least one hydrogen may be replaced by halogen;
M¹³ and M¹⁴ are independently hydrogen, halogen, alkyl having 1 to 5 carbons, or alkyl having 1 to 5 carbons in which at least one hydrogen is replaced by halogen;
X¹ is —OH, —NH₂, —OR¹⁵, —N(R¹⁵)₂, —COOH, —SH, —B(OH)₂ or —Si(R¹⁵)₃; and
in —OR¹⁵, —N(R¹⁵)₂ and —Si(R¹⁵)₃,
R¹⁵ is hydrogen or alkyl having 1 to 10 carbons, and in R¹⁵, at least one —CH₂— may be replaced by —O—, at least one —CH₂CH₂— may be replaced by —CH═CH—, and at least one hydrogen may be replaced by halogen.

7. The liquid crystal display device according to claim 1, wherein the alignable monomer is a compound represented by formula (1ε):
R¹-MES-Sp¹-P¹ (1ε)
wherein, in formula (1ε),
R¹ is alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen;
MES is a mesogen group having at least one ring; and
Sp¹ is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen, and in the groups, at least one hydrogen is replaced by a group selected from groups represented by formulas (1εa), (1εb), (1εc) and (1εd): 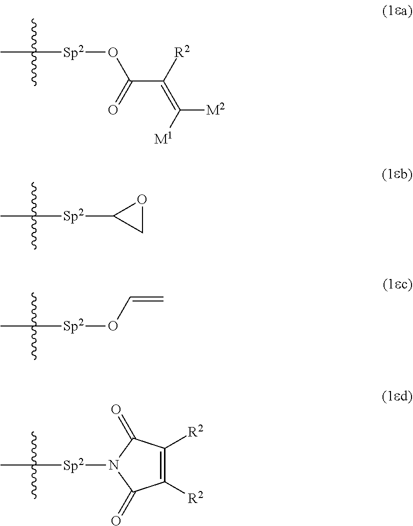
wherein, in formulas (1εa), (1εb), (1εc) and (1εd),
Sp² is a single bond or alkylene having 1 to 10 carbons, and in the alkylene, at least one —CH₂— may be replaced by —O—, —CO—, —COO—, —OCO— or —OCOO—, and at least one —(CH₂)₂— may be replaced by —CH═CH— or —C≡C—, and in the groups, at least one hydrogen may be replaced by halogen;
M¹ and M² are independently hydrogen, halogen, alkyl having 1 to 5 carbons, or alkyl having 1 to 5 carbons in which at least one hydrogen is replaced by halogen;
R² is hydrogen or alkyl having 1 to 15 carbons, and in the alkyl, at least one —CH₂— may be replaced by —O— or —S—, and at least one —(CH₂)₂— may be replaced by —CH═CH— or —C≡C—, and in the groups, at least one hydrogen may be replaced by halogen; and
in formula (1ε),
P¹ is a group selected from groups represented by formulas (1εe) and (1εf): 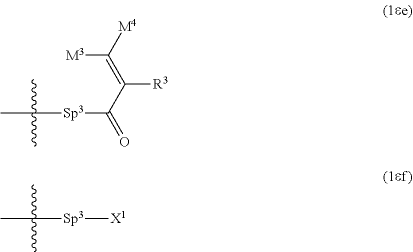
wherein, in formulas (1εe) and (1εf),
Sp³ is a single bond or alkylene having 1 to 10 carbons, and in the alkyl ene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;
M³ and M⁴ are independently hydrogen, halogen, alkyl having 1 to 5 carbons, or alkyl having 1 to 5 carbons in which at least one hydrogen is replaced by halogen;
X¹ is —OH, —NH₂, —OR⁵, —N(R⁵)₂, —COOH, —SH, —B(OH)₂ or —Si(R⁵)₃; and
R³ is a group selected from groups represented by formulas (1εg), (1εh) and 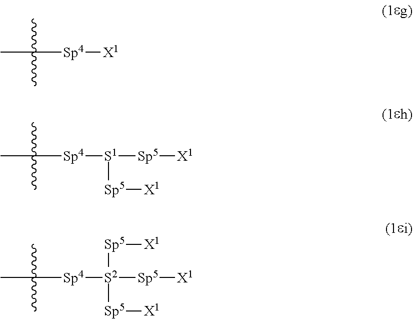
wherein, in formulas (1εg), (1εh) and (1εi),
Sp⁴ and Sp⁵ are independently a single bond or alkylene having 1 to 10 carbons, and in the alkylene, at least one —CH₂— may be replaced by —O—, —NH—, —CO—, —COO—, —OCO— or —OCOO—, and at least one —(CH₂)₂— may be replaced by —CH═CH— or —C≡C—, and in the groups, at least one hydrogen may be replaced by halogen;
S¹ is >CH— or >N—;
S² is >C< or >Si<; and
X¹ is —OH, —NH₂, —OR⁵, —N(R⁵)₂, —COOH, —SH, —B(OH)₂ or —Si(R⁵)₃; and
in —OR⁵, —N(R⁵)₂ and —Si(R⁵)_{[[2]}]3,
R⁵ is hydrogen or alkyl having 1 to 10 carbons, and in the alkyl, at least one —CH₂— may be replaced by —O—, and at least one —(CH₂)₂— may be replaced by —CH═CH—, and in the groups, at least one hydrogen may be replaced by halogen.

8. The liquid crystal display device according to claim 1, wherein
the polymer containing the alignable monomer is a copolymer with a reactive monomer.

9. The liquid crystal display device according to claim 1, wherein the alignment control layer has a thickness of 10 to 100 nanometers.

10. The liquid crystal display device according to claim 1, wherein at least one liquid crystal compound contained in the liquid crystal composition has negative dielectric anisotropy.

11. The liquid crystal display device according to claim 1, wherein molecular alignment of the liquid crystal compound contained in the liquid crystal composition is vertical alignment relative to a surface of the substrate by the alignment control layer, and
an angle of the vertical alignment to the substrate is 90±10 degrees.

12. The liquid crystal display device according to claim 1, wherein the molecular alignment of the liquid crystal compound contained in the liquid crystal composition is divided as aligned for every pixel.

13. The liquid crystal display device according to claim 1,
having no alignment film.

14. A display unit, comprising:
the liquid crystal display device according to claim 1; and
a backlight.
